(19) United States
(12) Patent Application Publication
(10) Pub. No.: US 2026/0222100 A1
(43) Pub. Date: Jul. 30, 2026

(54) PHYSICAL LAYER PROTOCOL DATA UNIT SENDING METHOD AND APPARATUS, AND PHYSICAL LAYER PROTOCOL DATA UNIT RECEIVING METHOD AND APPARATUS

(71) Applicant: HUAWEI TECHNOLOGIES CO., LTD., Shenzhen,Guangdong (CN)

(72) Inventors: Chenchen Liu, Shenzhen (CN); Zhengchun Zhou, Chengdu (CN); Bin Qian, Shenzhen (CN); Xiaohu Tang, Chengdu (CN); Xun Yang, Singapore (SG)

(21) Appl. No.: 19/147,266

(22) PCT Filed: Jan. 12, 2024
(86) PCT No.: PCT/CN2024/071986

§ 371 Date: Jul. 10, 2025

(30) Foreign Application Priority Data
Jan. 12, 2023 (CN) 202310074871.7

(51) Int. Cl. H04J 13/14; H04J 13/00

(52) U.S. Cl. CPC H04J 13/14; H04J 13/0014; H04J 13/0055

(57) ABSTRACT

This application provides a physical layer protocol data unit sending method and apparatus, and a physical layer protocol data unit receiving method and apparatus. In the method, a sequence set having a zero-correlation zone is constructed based on a Golay sequence pair having a zero-correlation zone and a Golay sequence pair having a low cross-correlation. A zero-correlation zone sequence may well support sensing measurement and ranging. In addition, sequences in the sequence set have a low cross-correlation, and may support a plurality of devices to perform concurrent transmission, to reduce interference when the plurality of devices simultaneously perform sensing or ranging, so that sensing measurement and ranging can be performed more accurately.

This application claims priority to Chinese Patent Application No. 202310074871.7, filed with the China National Intellectual Property Administration on Jan. 12, 2023 and entitled “PHYSICAL LAYER PROTOCOL DATA UNIT SENDING METHOD AND APPARATUS, AND PHYSICAL LAYER PROTOCOL DATA UNIT RECEIVING METHOD AND APPARATUS”, which is incorporated herein by reference in its entirety.

### TECHNICAL FIELD

This application relates to the communication field, and more specifically, to a physical layer protocol data unit sending method and apparatus, and a physical layer protocol data unit receiving method and apparatus.

### BACKGROUND

To support secure ranging, a secure ranging method based on a scrambled timestamp sequence (scrambled timestamp sequence, STS) is introduced in the 802.15.4z standard. Specifically, a transmit end obtains a 128-bit pseudo-random sequence S after performing encryption by using an advanced encryption standard (advanced encryption standard, AES), and maps the sequence S onto a string of pulse sequences, to form one or more segments of pseudo-random ranging reference signals. An authorized receive end may locally generate the same pseudo-random sequence S by using a same key, and estimate a time of arrival of a received signal by performing a correlation operation on the signal, to avoid interference from an unauthorized device and achieve secure ranging.

Ranging accuracy has a close relationship with an autocorrelation feature of the ranging reference signal. If all sidelobes of an autocorrelation function of the ranging reference signal are very low, accuracy of estimating the time of arrival of the signal is greatly improved. However, the STS is completely a random sequence, and a sidelobe of an autocorrelation function of a ranging reference signal formed based on the STS is a random value. Consequently, a sidelobe amplitude of the autocorrelation function is low, and accuracy of estimating the time of arrival is affected, greatly affecting ranging. In addition, a cross-correlation between STSs randomly generated by different devices cannot be ensured. When a cross-correlation between sequences of adjacent devices is large, strong interference is caused, and a ranging result is affected.

### SUMMARY

This application provides a physical layer protocol data unit sending method and apparatus, and a physical layer protocol data unit receiving method and apparatus, to perform sensing measurement or ranging more accurately.

According to a first aspect, a physical layer protocol data unit sending method is provided. The method may be performed by a sending device, or may be performed by a chip or a circuit configured in the sending device. This is not limited in this application. For ease of description, the following provides descriptions by using an example in which the method is performed by the sending device.

The method may include: The sending device generates a physical layer protocol data unit PPDU. The PPDU includes a first field, the first field is used for ranging or sensing, the first field is generated based on a first sequence in a sequence set or an equivalent deformation sequence of the first sequence, the sequence set includes M zero-correlation zone sequences, the M zero-correlation sequences are sequences in L1! zero-correlation sequences whose lengths are 2^{L}, a cross-correlation between any two sequences in the M zero-correlation sequences is less than or equal to a first threshold, a sequence in the L1! zero-correlation sequences is generated based on the first sequence and a second sequence, the first sequence is a complementary pair sequence in L1! pairs of Golay complementary pair sequences whose lengths are 2^{L1}, the second sequence is a pair of Golay complementary pair sequences that have a zero-correlation zone and whose sequence length is 2^{L2}, the L1! zero-correlation sequences and the L1! pairs of Golay complementary pair sequences are in a one-to-one correspondence, L1, L2, and M are all positive integers, and L1+L2=L. The sending device sends the PPDU.

In the foregoing technical solution, a sequence set having a zero-correlation zone is constructed based on a Golay sequence pair having a zero-correlation zone and a Golay sequence pair having a low cross-correlation, to well support sensing measurement and ranging. In addition, sequences in the sequence set have a low cross-correlation, and may support a plurality of devices to perform concurrent transmission, to reduce interference when the plurality of devices simultaneously perform sensing or ranging, so that sensing measurement and ranging can be performed more accurately.

According to a second aspect, a physical layer protocol data unit receiving method is provided. The method may be performed by a receiving device, or may be performed by a chip or a circuit configured in the receiving device. This is not limited in this application. For ease of description, the following provides descriptions by using an example in which the method is performed by the receiving device.

The method may include: The receiving device receives a physical layer protocol data unit PPDU. The PPDU includes a first field, the first field is used for ranging or sensing, the first field is generated based on a first sequence in a sequence set or an equivalent deformation sequence of the first sequence, the sequence set includes M zero-correlation zone sequences, the M zero-correlation sequences are sequences in L1! zero-correlation sequences whose lengths are 2L, a cross-correlation between any two sequences in the M zero-correlation sequences is less than or equal to a first threshold, a sequence in the L1! zero-correlation sequences is generated based on the first sequence and a second sequence, the first sequence is a complementary pair sequence in L1! pairs of Golay complementary pair sequences whose lengths are 2^{L1}, the second sequence is a pair of Golay complementary pair sequences that have a zero-correlation zone and whose sequence length is 2^{L2}, the L1! zero-correlation sequences and the L1! pairs of Golay complementary pair sequences are in a one-to-one correspondence, L1, L2, and M are all positive integers, and L1+L2=L. The receiving device performs ranging or sensing measurement based on the PPDU.

For beneficial effects of the second aspect, refer to the descriptions of the first aspect. Details are not described herein again.

In some implementations of the first aspect and the second aspect, a sequence eₘ in the L1! zero-correlation sequences satisfies the following formula:

$${e}_{m} = c ⊗ \frac{{a}_{m} + {b}_{m}}{2} - d ⊗ \frac{{b}_{m} - {a}_{m}}{2} .$$

(aₘ, bₘ) is a pair of sequences in the L1! pairs of Golay complementary pair sequences, (c, d) is a pair of Golay complementary pair sequences that have a zero-correlation zone, and 0≤m≤L1!−1.

In some implementations of the first aspect and the second aspect, a Golay complementary pair sequence whose length is 2ⁿ is constructed and generated based on functions f(x) and g(x), and f(x) and g(x) meet the following condition:

$$\begin{matrix}f ( x ) = {{\sum }^{n - 1}}_{k = 1} {x}_{π ( k )} {x}_{π ( k + 1 )} + {{\sum }^{n}}_{k = 1} {c}_{k} {x}_{k} + {c}_{0} \text{?} ; and \\ g ( x ) = f ( x ) + {x}_{π ( 1 )} .\end{matrix}$$

$$\text{?} \text{indicates text missing or illegible when filed}$$

π is a permutation of a set {1, 2, . . . , n}, the set {1, 2, . . . , n} includes n! permutations, xⱼ is a value of a j^{th} bit when x is written in binary, j=1, 2, . . . , n, when a permutation of the set {1, 2, . . . , n} is used and a value of x is obtained by traversing from 0 to 2ⁿ−1, f(x) and g(x) respectively correspond to sequences p and q whose lengths are 2ⁿ, the sequences p and q are a pair of Golay complementary pair sequences, cₖ∈{0,1}, and c₀ is a natural number.

In some implementations of the first aspect and the second aspect, the equivalent deformation sequence of the first sequence includes a sequence generated by negating the first sequence or reversing the first sequence.

According to a third aspect, a physical layer protocol data unit sending method is provided. The method may be performed by a sending device, or may be performed by a chip or a circuit configured in the sending device. This is not limited in this application. For ease of description, the following provides descriptions by using an example in which the method is performed by the sending device.

The method may include: The sending device generates a physical layer protocol data unit PPDU. The PPDU includes a first field, the first field is used for sensing or ranging, the first field is generated based on a first sequence in a sequence set or an equivalent deformation sequence of the first sequence, the sequence set includes M sequences, the M sequences are sequences corresponding to a first set in L sequences whose lengths are N, a cross-correlation between any two sequences in the M sequences is less than or equal to a second threshold, the first set includes L sampling values, each of the L sequences corresponds to one of the L sampling values, each sequence is a sampling sequence obtained by sampling, by using a corresponding sampling value, a second sequence whose length is N, and the second sequence is an m-sequence. The sending device sends the PPDU.

In the foregoing technical solution, different sampling sequences are constructed based on an m-sequence having a low-correlation zone, and a sequence set having a low cross-correlation is selected from the sampling sequences. The m-sequence having a low-correlation zone may well support sensing measurement and ranging. In addition, sequences in the sequence set have a low cross-correlation, and may support a plurality of devices to perform concurrent transmission, to reduce interference when the plurality of devices simultaneously perform sensing or ranging, so that sensing measurement and ranging can be performed more accurately.

According to a fourth aspect, a physical layer protocol data unit receiving method is provided. The method may be performed by a receiving device, or may be performed by a chip or a circuit configured in the receiving device. This is not limited in this application. For ease of description, the following provides descriptions by using an example in which the method is performed by the receiving device.

The method may include: The receiving device receives a physical layer protocol data unit PPDU. The PPDU includes a first field, the first field is used for sensing or ranging, the first field is generated based on a first sequence in a sequence set or an equivalent deformation sequence of the first sequence, the sequence set includes M sequences, the M sequences are sequences corresponding to a first set in L sequences whose lengths are N, a cross-correlation between any two sequences in the M sequences is less than or equal to a second threshold, the first set includes L sampling values, each of the L sequences corresponds to one of the L sampling values, each sequence is a sampling sequence obtained by sampling, by using a corresponding sampling value, a second sequence whose length is N, and the second sequence is an m-sequence. The receiving device performs ranging or sensing measurement based on the PPDU.

In some implementations of the third aspect and the fourth aspect, a sampling sequence obtained by sampling the second sequence by using a sampling value d satisfies the following formula:

$${s}_{d} ( n ) = \{ \begin{matrix}s ( d * n + {k}_{0} ) , & if d * n + {k}_{0} \leq N \\ s ( r ) , r = mod ( d * n + {k}_{0} - 1 , N ) + 1 , & if d * n + {k}_{0} > N\end{matrix} .$$

s_{d}(n) is an n^{th} element in the sampling sequence, n=1, 2, . . . , N, s(j) is a j^{th} element in the second sequence, j=1, 2, . . . , N, and k₀ is a natural number.

In some implementations of the third aspect and the fourth aspect, the first set is a set of odd numbers less than or equal to N, or the first set is a set of even numbers less than or equal to N.

According to a fifth aspect, a communication apparatus is provided. The apparatus is configured to perform the method according to the first aspect or the third aspect. Specifically, the apparatus may include units and/or modules, for example, a processing unit and/or a communication unit, configured to perform the method according to any one of the first aspect or the third aspect and the possible implementations of the first aspect or the third aspect.

In an implementation, the apparatus is a sending device. When the apparatus is a sending device, the communication unit may be a transceiver or an input/output interface, and the processing unit may be at least one processor. Optionally, the transceiver may be a transceiver circuit. Optionally, the input/output interface may be an input/output circuit.

In another implementation, the apparatus is a chip, a chip system, or a circuit used in a sending device. When the apparatus is a chip, a chip system, or a circuit used in the sending device, the communication unit may be an input/output interface, an interface circuit, an output circuit, an input circuit, a pin, a related circuit, or the like on the chip, the chip system, or the circuit, and the processing unit may be at least one processor, processing circuit, logic circuit, or the like.

According to a sixth aspect, a communication apparatus is provided. The apparatus is configured to perform the method according to the second aspect or the fourth aspect. Specifically, the apparatus may include units and/or modules, for example, a processing unit and/or a communication unit, configured to perform the method according to any one of the second aspect or the fourth aspect and the possible implementations of the second aspect or the fourth aspect.

In an implementation, the apparatus is a receiving device. When the apparatus is a receiving device, the communication unit may be a transceiver or an input/output interface, and the processing unit may be at least one processor. Optionally, the transceiver may be a transceiver circuit. Optionally, the input/output interface may be an input/output circuit.

In another implementation, the apparatus is a chip, a chip system, or a circuit used in a receiving device. When the apparatus is a chip, a chip system, or a circuit used in the receiving device, the communication unit may be an input/output interface, an interface circuit, an output circuit, an input circuit, a pin, a related circuit, or the like on the chip, the chip system, or the circuit, and the processing unit may be at least one processor, processing circuit, logic circuit, or the like.

According to a seventh aspect, a communication apparatus is provided. The apparatus includes at least one processor. The at least one processor is coupled to at least one memory, the at least one memory is configured to store a computer program or instructions, and the at least one processor is configured to invoke the computer program or the instructions from the at least one memory and run the computer program or the instructions, so that the communication apparatus performs the method according to any one of the first aspect, the third aspect, or the fifth aspect and the possible implementations of the first aspect, the third aspect, or the fifth aspect.

In an implementation, the apparatus is a sending device.

In another implementation, the apparatus is a chip, a chip system, or a circuit used in a sending device.

According to an eighth aspect, a communication apparatus is provided. The apparatus includes at least one processor. The at least one processor is coupled to at least one memory, the at least one memory is configured to store a computer program or instructions, and the at least one processor is configured to invoke the computer program or the instructions from the at least one memory and run the computer program or the instructions, so that the communication apparatus performs the method according to any one of the second aspect or the fourth aspect and the possible implementations of the second aspect or the fourth aspect.

In an implementation, the apparatus is a receiving device.

In another implementation, the apparatus is a chip, a chip system, or a circuit used in a receiving device.

According to a ninth aspect, a processor is provided, to perform the method provided in the foregoing aspects.

Unless otherwise specified, or if operations such as sending, and obtaining/receiving related to the processor do not contradict an actual function or internal logic of the operations in related descriptions, the operations may be understood as operations such as outputting, receiving, and inputting of the processor, or operations such as sending and receiving performed by a radio frequency circuit and an antenna. This is not limited in this application.

According to a tenth aspect, a computer-readable storage medium is provided. The computer-readable storage medium stores program code executed by a device, and the program code is used to perform the method according to any one of the first aspect to the fourth aspect and the possible implementations of the first aspect to the fourth aspect.

According to an eleventh aspect, a computer program product including instructions is provided. When the computer program product runs on a computer, the computer is enabled to perform the method according to any one of the first aspect to the fourth aspect and the possible implementations of the first aspect to the fourth aspect.

According to a twelfth aspect, a chip is provided. The chip includes a processor and a communication interface. The processor reads, through the communication interface, instructions stored in a memory, to perform the method according to any one of the first aspect to the fourth aspect and the possible implementations of the first aspect to the fourth aspect.

Optionally, in an implementation, the chip further includes the memory. The memory stores a computer program or instructions. The processor is configured to execute the computer program or the instructions stored in the memory. When the computer program or the instructions are executed, the processor is configured to perform the method according to any one of the first aspect to the fourth aspect and the possible implementations of the first aspect to the fourth aspect.

According to a thirteenth aspect, a communication system is provided. The communication system includes the communication apparatus shown in the seventh aspect and the eighth aspect.

### BRIEF DESCRIPTION OF DRAWINGS

FIG. 1 is a diagram of two application scenarios according to this application;

FIG. 2 is a diagram of a structure of a PPDU of a UWB communication system defined in a standard;

FIG. 3 is a diagram of a structure of an SHR;

FIG. 4 is a schematic block diagram of a physical layer protocol data unit sending and receiving method according to an embodiment of this application;

FIG. 5 is a diagram of a cumulative distribution of cross-correlation results between 16 selected sequences;

FIG. 6 is a schematic block diagram of another physical layer protocol data unit sending and receiving method according to an embodiment of this application;

FIG. 7 is a diagram of a 13-order shift register;

FIG. 8 is a diagram of a cumulative distribution of cross-correlation results between 16 selected sequences;

FIG. 9 is a schematic block diagram of a communication apparatus 200 according to this application; and

FIG. 10 is a diagram of a structure of a communication apparatus 300 according to this application.

### DESCRIPTION OF EMBODIMENTS

The following describes technical solutions of embodiments in this application with reference to accompanying drawings.

Embodiments of this application may be applied to a wireless personal area network (wireless personal area network, WPAN) based on a UWB technology. Currently, a standard used by the WPAN is an institute of electrical and electronics engineer (institute of electrical and electronics engineer, IEEE) 802.15 series. The WPAN may be used for communication between digital auxiliary devices in a small range, for example, a telephone, a computer, and an auxiliary device, and a working range of the WPAN is usually within 10 m. Technologies supporting the wireless personal area network include Bluetooth (Bluetooth), ZigBee (ZigBee), ultra-wideband, an IrDA infrared (infrared) connection technology, HomeRF, and the like. However, a person skilled in the art easily understands that, various aspects in this application may be extended to another network using various standards or protocols, for example, a wireless local area network (Wireless Local Area Network, WLAN), a high performance radio LAN (High Performance Radio LAN, HIPERLAN) (a wireless standard similar to the IEEE 802.11 standard, mainly used in Europe), a wide area network (WAN), or another network that is currently known or developed in the future. From a perspective of network composition, the WPAN is located at a bottom layer of an entire network architecture and is used for a wireless connection between devices in a small range, that is, a point-to-point short-range connection, and may be considered as a short-range wireless communication network. Based on different application scenarios, WPANs are further classified into a high rate (high rate, HR)-WPAN and a low rate (low rate)-WPAN. The HR-WPAN may be used to support various high-rate multimedia applications, including high-quality sound image delivery, multi-megabyte music and image document transmission, and the like. The LR-WPAN may be used for common services in daily life.

In the WPAN, devices may be classified into a full-function device (full-function device, FFD) and a reduced-function device (reduced-function device, RFD) based on communication capabilities of the devices. FFD devices can communicate with each other, and the FFD device and the RFD device can communicate with each other. RFD devices cannot directly communicate with each other, and can only communicate with the FFD device, or forward data externally via one FFD device. An FFD device associated with the RFD is referred to as a coordinator (coordinator) of the RFD. The RFD device is mainly configured for a simple control application, for example, a light switch and a passive infrared sensor, transmits a small amount of data, and occupies a small quantity of transmission resources and communication resources. Therefore, costs of the RFD device are low. The coordinator may also be referred to as a personal area network (personal area network, PAN) coordinator, a central control node, or the like. The PAN coordinator is a main control node of an entire network, and each ad hoc network can have only one PAN coordinator having functions of member identity management, link information management, and packet forwarding. Optionally, the device in embodiments of this application may be a device that supports a plurality of WPAN standards such as 802.15.4a, 802.15.4z, and a currently discussed version or a later version.

In embodiments of this application, the device may be a communication server, a router, a switch, a bridge, a computer, a mobile phone, a home smart device, a vehicle-mounted communication device, or the like.

In embodiments of this application, the device includes a hardware layer, an operating system layer running above the hardware layer, and an application layer running above the operating system layer. The hardware layer includes hardware such as a central processing unit (central processing unit, CPU), a memory management unit (memory management unit, MMU), and a memory (also referred to as a main memory). The operating system may be any one or more types of computer operating systems that implement service processing through a process (process), for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not specially limited in embodiments of this application, provided that a program that records code of the method provided in embodiments of this application can be run to perform communication according to the method provided in embodiments of this application. For example, the method provided in embodiments of this application may be performed by the FFD or the RFD, or a functional module that is in the FFD or the RFD and that can invoke and execute a program.

In addition, aspects or features of this application may be implemented as a method, an apparatus, or a product that uses standard programming and/or engineering technologies. The term “product” used in this application covers a computer program that can be accessed from any computer-readable component, carrier or medium. For example, the computer-readable medium may include but is not limited to: a magnetic storage component (for example, a hard disk, a floppy disk, or a magnetic tape), an optical disc (for example, a compact disc (compact disc, CD) or a digital versatile disc (digital versatile disc, DVD)), a smart card and a flash memory component (for example, erasable programmable read-only memory (erasable programmable read-only memory, EPROM), a card, a stick, or a key drive). In addition, various storage media described in this specification may represent one or more devices and/or other machine-readable media that are configured to store information. The term “machine-readable media” may include but is not limited to a radio channel, and various other media that can store, include, and/or carry instructions and/or data.

Alternatively, embodiments of this application are further applicable to a wireless local area network system, for example, an internet of things (internet of things, IoT) network or vehicle-to-everything (Vehicle to X, V2X). Certainly, embodiments of this application may be further applied to other possible communication systems, for example, a long term evolution (long term evolution, LTE) system, an LTE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communication system, a 5th generation (5th generation, 5G) communication system, and a future sixth generation (6th generation, 6G) communication system.

The foregoing communication system applicable to this application is only an example for description, and the communication system applicable to this application is not limited thereto. This is uniformly described herein, and details are not described below again.

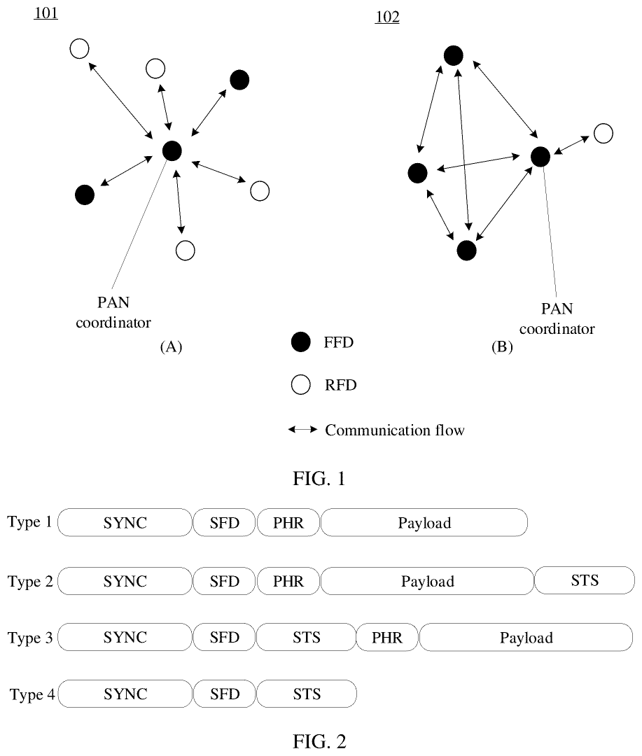

FIG. 1 is a diagram of two application scenarios according to this application. In a system 101 shown in (A) in FIG. 1, a plurality of FFD devices and a plurality of RFD devices form a communication system with a star topology (star topology). One FFD is a PAN controller. In the communication system with the star topology, the PAN controller performs data transmission with one or more other devices, that is, a one-to-many or many-to-one data transmission architecture may be established between a plurality of devices. In a system 102 shown in (B) in FIG. 1, a plurality of FFD devices and one RFD device form a communication system with a peer-to-peer topology (peer-to-peer topology). One FFD is a PAN controller. In the communication system with the peer-to-peer topology, a many-to-many data transmission architecture may be established between a plurality of different devices.

It should be understood that (A) in FIG. 1 and (B) in FIG. 1 are merely simplified diagrams for ease of understanding, and do not constitute a limitation on an application scenario of this application. For example, the system 101 and/or the system 102 may further include another FFD and/or another RFD.

The device in this application may be a wireless communication chip, a wireless sensor, or a wireless communication terminal, for example, a user terminal, a user apparatus, an access apparatus, a subscriber station, a subscriber unit, a mobile station, a user agent, and user equipment that support a Wi-Fi communication function. The user terminal may include various handheld devices, vehicle-mounted devices, wearable devices, internet of things (internet of things, IoT) devices, or computing devices that have a wireless communication function, or another processing device connected to a wireless modem, user equipment (user equipment, UE) of various forms, a mobile station (mobile station, MS), a terminal (terminal), a terminal device (terminal equipment), a portable communication device, a handheld device, a portable computing device, an entertainment device, a game device or system, a global positioning system device, or any other proper device configured to perform network communication via a wireless medium. In addition, the device may support the 802.15.4ab standard or a next-generation standard of 802.15.4ab. The device may further support a plurality of standards such as 802.15.4a, 802.15.4-2011, 802.15.4-2015, and 802.15.4z. The device may further support a plurality of wireless local area network (wireless local area network, WLAN) standards of the 802.11 family, for example, 802.11ax, 802.11ac, 802.11n, 802.11g, 802.11b, 802.11a, and a next generation of 802.11be.

For ease of understanding of the technical solutions in embodiments of this application, some terms or concepts that are used in embodiments of this application are first briefly described.
1. A UWB technology is a wireless carrier communication technology in which data is transmitted by using a nanosecond-level non-sine wave narrow pulse, and therefore, a wide frequency spectrum range occupied by the narrow pulse is occupied. Due to a narrow pulse and an extremely low radiation spectral density of the ultra-wideband, a UWB system has advantages such as a strong multipath resolution capability, low power consumption, and high confidentiality. Because in the ultra-wideband technology, a carrier in a conventional communication system does not need to be used, but data is transmitted by sending and receiving an extremely narrow pulse at a nanosecond level or at a level lower than a nanosecond level, the ultra-wideband technology has a high requirement on time synchronization of a transceiver device, and a design of a synchronization sequence of the ultra-wideband technology is crucial.

For a sequence a=[a₀,a₁,a₂, . . . , a_{N-1}] whose sequence length is N, a periodic autocorrelation function Rₐ(τ) of the sequence is defined as follows:

$${R}_{a} ( τ ) = {\sum }_{n - 0}^{N - 1} {a}_{n} \times {a}_{n + τ}^{H} .$$

τ∈[0,N−1], and a_{n+τ}=a_{n+τ-N}. When n+τ≥N,

$${a}_{n + τ}^{H}$$

is a conjugate of a_{n+τ}.

When a sidelobe amplitude (an absolute value of Rₐ(τ) when τ≠0) of an autocorrelation function of the sequence is |Rₐ(τ)|, in a sequence design, it is usually expected that the sidelobe amplitude is as small as possible. That is:

$$\vert {R}_{a} ( τ ) \vert \leq ε . \vert τ \vert \leq Z , and τ \neq 0.$$

For example, when ε=0, the sequence a is referred to as a zero-correlation zone sequence; and when ε<<N, the sequence a is referred to as a sequence having a low-correlation zone.

b=[b₀,b₁,b₂, . . . ,b_{N-1}] is another sequence whose length is N. In this case, a periodic cross-correlation function R_{a,b} (τ) of the sequences a and b is defined as follows:

$${R}_{a , b} ( τ ) = {\sum }_{n = 0}^{N - 1} {a}_{n} \times {b}_{n + τ}^{H} .$$

R_{Cmax} represents a maximum value of an amplitude |R_{a,b}(τ)| of the periodic cross-correlation function. Usually, for a sequence set, it is expected that R_{Cmax} is as small as possible. To be specific, a cross-correlation value between any two sequences in the set is as small as possible. Usually, a normalized cross-correlation peak is used for measurement. The normalized cross-correlation peak Cₙₒᵣₘ is defined as follows:

$${C}_{n o r m} = 20 * {log}_{10} \frac{{R}_{Cmax}}{N} .$$

2. A pseudo-random sequence is a determined sequence having a specific random feature. The pseudo-random sequence is not only a determined sequence generated by a shift register, but also a random sequence having a random feature. Because the pseudo-random sequence also has the random feature, whether a generated sequence is a true random sequence or a pseudo random sequence cannot be determined based on a feature of the sequence, and can be determined only based on a sequence generation method. A pseudo-random sequence series has good randomness and a correlation function close to white noise, and has pre-determinability and repeatability.
3. A Golay complementary pair sequence includes a pair of sequences, and a sidelobe amplitude of a sum of autocorrelation functions of the pair of sequences is 0.
4. An m-sequence is short for a longest linear shift register sequence. The m-sequence is a longest code sequence generated by a multi-level shift register or a delay element of the multi-level shift register through linear feedback. In a binary shift register, if n is a quantity of levels of the shift register, an n-level shift register has a total of 2ⁿ states. There are still 2ⁿ−1 states in addition to an all zeros state. Therefore, a code sequence that has a maximum length and that can be generated by the n-level shift register has 2ⁿ−1 bits. In other words, a longest periodicity generated by an n-level linear feedback shift register is equal to 2ⁿ−1. When a periodicity of a sequence {aᵢ} generated by the n-level linear shift register is 2ⁿ−1, {aᵢ} is referred to as an n-level m-sequence.
5. Primitive polynomial: It is assumed that f(x) is a polynomial with an integer coefficient. If f(x) cannot be factored into a product of two polynomials, f(x) is referred to as a primitive polynomial. For any initial sequence whose given length is n and that is of an n-level linear shift register, if a generator polynomial of the linear shift register is an n-level primitive polynomial, an n-level m-sequence whose periodicity is 2ⁿ−1 may be generated through shifting by the linear shift register.
6. A permutation is to exchange locations of elements in a set. For example, a set {1, 2, 3} includes 3! permutations: {1, 2, 3}, {1, 3, 2}, {2, 1, 3}, {2, 3, 1}, {3, 1, 2}, and {3, 2, 1}.

FIG. 2 is a diagram of a structure of a PPDU of a UWB communication system defined in a standard. A ranging frame shown in a type 1 includes a synchronization header (synchronization header, SHR), a physical header (physical header, PHR), and a payload (payload). The SHR includes a synchronization (synchronization, SYNC) field and a start frame delimiter (start frame delimiter, SFD) field. A type 2 and a type 3 each includes an SHR, a PHR, a payload, and a scrambled timestamp sequence (scrambled timestamp sequence, STS). For a specific composition sequence, refer to FIG. 2. A type 4 includes an SHR and an STS.

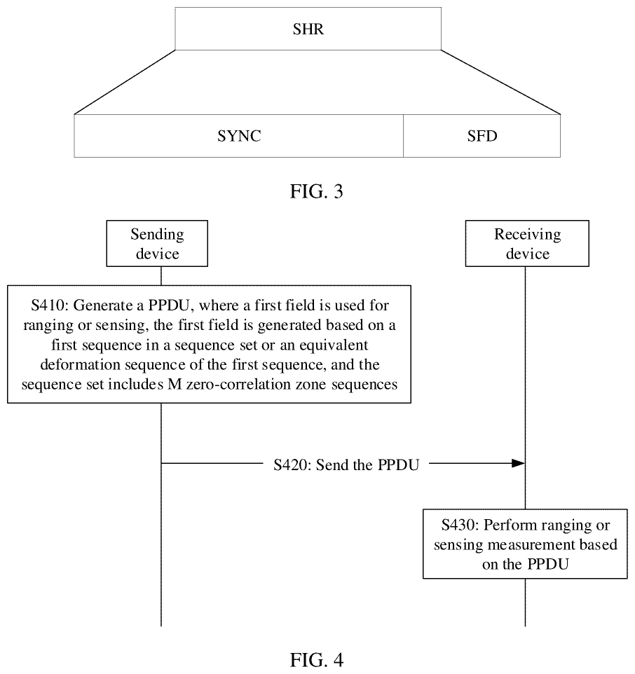

FIG. 3 is a diagram of a structure of an SHR. As described above, the SHR includes an SYNC field and an SFD field. The SYNC field includes a plurality of repeated basic symbols, and the basic symbol is generated based on a preamble code sequence. A length of a preamble code (preamble code) may be 31, 91, or 127. It may also be understood as that a code length of the preamble code is 31, 91, or 127.

To support secure ranging, a secure ranging method based on a scrambled timestamp sequence (scrambled timestamp sequence, STS) is introduced in the 802.15.4z standard. Specifically, a transmit end obtains a 128-bit pseudo-random sequence S after performing encryption by using an advanced encryption standard (advanced encryption standard, AES), and maps the 128-bit pseudo-random sequence S onto a string of pulse sequences. Specifically, a bit whose value is 0 is mapped onto a positive pulse, and a bit whose value is 1 is mapped onto a negative pulse, to form one or more segments of pseudo-random ranging reference signals. An authorized receive end may locally generate the same pseudo-random sequence S by using a same key, and estimate a time of arrival of a signal corresponding to an STS field in a received PPDU by performing a correlation operation on the signal, to avoid interference from an unauthorized device and achieve secure ranging.

Ranging accuracy has a close relationship with an autocorrelation feature of the ranging reference signal. If all sidelobes of an autocorrelation function of the ranging reference signal are very low, accuracy of estimating the time of arrival of the signal is greatly improved. However, the STS is completely a random sequence, and a sidelobe of an autocorrelation function of a ranging reference signal formed based on the STS is a random value. Consequently, a sidelobe amplitude of the autocorrelation function is low, and accuracy of estimating the time of arrival is affected, greatly affecting ranging. In addition, a cross-correlation between STSs randomly generated by different devices cannot be ensured. When a cross-correlation between sequences of adjacent devices is large, strong interference is caused, and a ranging result is affected.

In view of this, this application provides a physical layer protocol data unit sending and receiving method, to effectively resolve the foregoing technical problem. The following describes in detail the method provided in this application.

FIG. 4 is a schematic block diagram of a physical layer protocol data unit sending and receiving method according to an embodiment of this application.

S410: A sending device generates a PPDU.

The PPDU includes a first field, the first field is used for ranging or sensing, the first field is generated based on a first sequence in a sequence set or an equivalent deformation sequence of the first sequence, the sequence set includes M zero-correlation zone sequences, the M zero-correlation sequences are sequences in L1! zero-correlation sequences whose lengths are 2^{L}, a cross-correlation between any two sequences in the M zero-correlation sequences is less than or equal to a first threshold, a sequence in the L1! zero-correlation sequences is generated based on the first sequence and a second sequence, the first sequence is a complementary pair sequence in L1! pairs of Golay complementary pair sequences whose lengths are 2^{L1}, the second sequence is generated based on a pair of Golay complementary pair sequences that have a zero-correlation zone and whose sequence length is 2^{L2}, the L1! zero-correlation sequences and the L1! pairs of Golay complementary pair sequences are in a one-to-one correspondence, L1, L2, and M are all positive integers, and L1+L2=L.

For example, the equivalent deformation sequence of the first sequence includes a sequence generated by negating the first sequence or reversing the first sequence.

It may be understood that, that the cross-correlation herein is less than or equal to the first threshold means that a normalized cross-correlation peak of any two sequences is less than or equal to the first threshold. A smaller first threshold indicates a lower cross-correlation between two sequences.

For example, the STS field in FIG. 2 may be replaced with the first field. Details are not described herein again.

For ease of understanding, the following describes a possible generation step of a sequence set including M zero-correlation zone sequences.
Step 1: Decompose the sequence length. Because a sequence length of a sequence in a sequence set that needs to be designed is 2^{L}, it is assumed that L=L1+L2.
Step 2: Construct, based on L1, L1! Golay complementary pair sequences whose lengths are 2^{L1}, where (aₘ, bₘ) is a pair of Golay complementary pair sequences, and 0≤m≤L1!−1.

The following describes how to construct, based on n (n is any positive integer), n! Golay complementary pair sequences whose lengths are 2ⁿ. In a possible implementation, the Golay complementary pair sequence whose length is 2ⁿ is constructed and generated based on functions f(x) and g(x), and f(x) and g(x) meet the following condition:

$$f ( x ) = {\sum }_{k = 1}^{n - 1} {x}_{π ( k )} {x}_{π ( k + 1 )} + {\sum }_{k = 1}^{n} {c}_{k} {x}_{k} + {c}_{0} ; and$$

$$g ( x ) = f ( x ) + {x}_{π ( 1 )} .$$

π is a permutation of a set {1, 2, . . . , n}, the set {1, 2, . . . , n} includes n! permutations, xⱼ is a value of a j^{th} bit when x is written in binary, j=1, 2, . . . , n, when a permutation of the set {1, 2, . . . , n} is used and a value of x is obtained by traversing from 0 to 2ⁿ−1, f(x) and g(x) respectively correspond to sequences p and q whose lengths are 2ⁿ, the sequences p and q are a pair of Golay complementary pair sequences, cₖ∈{0,1}, and c₀ ∈{0,1}.

It should be understood that, the sequence p is used as an example. When a permutation of the set {1, 2, . . . , n} is used and the value of x is any value obtained by traversing from 0 to 2ⁿ−1, only a value at a length location in the sequence p is generated, and a sequence whose length is 2′ is generated only after 0 to 2ⁿ−1 are traversed. The same is true for the sequence q. Details are not described herein again.

Then, it can be learned that n! Golay complementary pair sequences whose lengths are 2ⁿ may be correspondingly generated based on n! permutations of the set {1, 2, . . . , n}.
Step 3: Construct, based on L2, a pair of Golay complementary pair sequences (c, d) that have a zero-correlation zone and whose sequence length is 2^{L2}.

For example, L2! pairs of Golay complementary pair sequences whose lengths are 2^{L2} may be constructed in the method in step 2, and a pair of Golay complementary pair sequences (c, d) having a zero-correlation zone is selected from the L2! pairs of constructed Golay complementary pair sequences whose lengths are 2^{L2}. A method for determining (c, d) is not limited in this application.
Step 4: Generate, based on the L1! pairs of Golay complementary pair sequences (aₘ, bₘ) whose lengths are 2^{L1} and the Golay complementary pair sequence (c, d) with a zero-correlation zone, the L1! zero-correlation sequences whose lengths are 2^{L}.

For example, a sequence eₘ in the L1! zero-correlation sequences whose lengths are 2^{L} meets the following condition:

$${e}_{m} = c ⊗ \frac{{a}_{m} + {b}_{m}}{2} - d ⊗ \frac{{b}_{m} - {a}_{m}}{2} .$$

0≤m≤L1!−1, and ⊗ indicates a Kronecker product.
Step 5: Select, based on the first threshold, M sequences from the L1! zero-correlation sequences whose lengths are 2^{L}, where a cross-correlation between any two sequences in the M sequences is less than or equal to the first threshold.

For example, when L1=11, L1=2, and M=16. When the first threshold is −24 dB, 16 sequences in the generated sequence set are shown in Table 1.

TABLE 1

| Sequence | |
|---|---|
| number | Sequence value |
| 1 | 1 1 1 −1 1 1 −1 1 1 1 1 −1 −1 −1 1 −1 1 1 1 −1 1 1 −1 1 −1 −1 −1 1 1 1 −1 1 1 1 |
| | 1 −1 1 1 −1 1 1 1 1 −1 −1 −1 1 −1 −1 −1 −1 1 −1 −1 1 −1 1 1 1 −1 −1 −1 1 −1 1 |
| | 1 1 −1 1 1 −1 1 1 1 1 −1 −1 −1 1 −1 1 1 1 −1 1 1 −1 1 −1 −1 −1 1 1 1 −1 1 −1 −1 |
| | −1 1 −1 −1 1 −1 −1 −1 −1 1 1 1 −1 1 1 1 1 −1 1 1 −1 1 −1 −1 −1 1 1 1 −1 1 1 1 1 |
| | −1 1 1 −1 1 1 1 1 −1 −1 −1 1 −1 1 1 1 −1 1 1 −1 1 −1 −1 −1 1 1 1 −1 1 1 1 1 −1 1 |
| | 1 −1 1 1 1 1 −1 −1 −1 1 −1 −1 −1 −1 1 −1 −1 1 −1 1 1 1 −1 −1 −1 1 −1 −1 −1 −1 |
| | 1 −1 −1 1 −1 −1 −1 −1 1 1 1 −1 1 −1 −1 −1 1 −1 −1 1 −1 1 1 1 −1 −1 −1 1 −1 1 1 |
| | 1 −1 1 1 −1 1 1 1 1 −1 −1 −1 1 −1 −1 −1 −1 1 −1 −1 1 −1 1 1 1 −1 −1 −1 1 −1 1 |
| | 1 1 −1 1 1 −1 1 1 1 1 −1 −1 −1 1 −1 1 1 1 −1 1 1 −1 1 −1 −1 −1 1 1 1 −1 1 1 1 1 |
| | −1 1 1 −1 1 1 1 1 −1 −1 −1 1 −1 −1 −1 −1 1 −1 −1 1 −1 1 1 1 −1 −1 −1 1 −1 1 1 |
| | 1 −1 1 1 −1 1 1 1 1 −1 −1 −1 1 −1 1 1 1 −1 1 1 −1 1 −1 −1 −1 1 1 1 −1 1 −1 −1 |
| | −1 1 −1 −1 1 −1 −1 −1 −1 1 1 1 −1 1 1 1 1 −1 1 1 −1 1 −1 −1 −1 1 1 1 −1 1 −1 |
| | −1 −1 1 −1 −1 1 −1 −1 −1 −1 1 1 1 −1 1 −1 −1 −1 1 −1 −1 1 −1 1 1 1 −1 −1 −1 1 |
| | −1 −1 −1 −1 1 −1 −1 1 −1 −1 −1 −1 1 1 1 −1 1 1 1 1 −1 1 1 −1 1 −1 −1 −1 1 1 1 |
| | −1 1 1 1 1 −1 1 1 −1 1 1 1 1 −1 −1 −1 1 −1 1 1 1 −1 1 1 −1 1 −1 −1 −1 1 1 1 −1 1 |
| | −1 −1 −1 1 −1 −1 1 −1 −1 −1 −1 1 1 1 −1 1 1 1 1 −1 1 1 −1 1 −1 −1 −1 1 1 1 −1 |
| | 1 1 1 1 −1 1 1 −1 1 1 1 1 −1 −1 −1 1 −1 1 1 1 −1 1 1 −1 1 −1 −1 −1 1 1 1 −1 1 1 |
| | 1 1 −1 1 1 −1 1 1 1 1 −1 −1 −1 1 −1 −1 −1 −1 1 −1 −1 1 −1 1 1 1 −1 −1 −1 1 −1 |
| | 1 1 1 −1 1 1 −1 1 1 1 1 −1 −1 −1 1 −1 1 1 1 −1 1 1 −1 1 −1 −1 −1 1 1 1 −1 1 −1 |
| | −1 −1 1 −1 −1 1 −1 −1 −1 −1 1 1 1 −1 1 1 1 1 −1 1 1 −1 1 −1 −1 −1 1 1 1 −1 1 1 |
| | 1 1 −1 1 1 −1 1 1 1 1 −1 −1 −1 1 −1 1 1 1 −1 1 1 −1 1 −1 −1 −1 1 1 1 −1 1 1 1 1 |
| | −1 1 1 −1 1 1 1 1 −1 −1 −1 1 −1 −1 −1 −1 1 −1 −1 1 −1 1 1 1 −1 −1 −1 1 −1 −1 |
| | −1 −1 1 −1 −1 1 −1 −1 −1 −1 1 1 1 −1 1 −1 −1 −1 1 −1 −1 1 −1 1 1 1 −1 −1 −1 1 |
| | −1 1 1 1 −1 1 1 −1 1 1 1 1 −1 −1 −1 1 −1 −1 −1 −1 1 −1 −1 1 −1 1 1 1 −1 −1 −1 |
| | 1 −1 −1 −1 −1 1 −1 −1 1 −1 −1 −1 −1 1 1 1 −1 1 −1 −1 −1 1 −1 −1 1 −1 1 1 1 −1 |
| | −1 −1 1 −1 −1 −1 −1 1 −1 −1 1 −1 −1 −1 −1 1 1 1 −1 1 1 1 1 −1 1 1 −1 1 −1 −1 |
| | −1 1 1 1 −1 1 −1 −1 −1 1 −1 −1 1 −1 −1 −1 −1 1 1 1 −1 1 −1 −1 −1 1 −1 −1 1 −1 |
| | 1 1 1 −1 −1 −1 1 −1 1 1 1 −1 1 1 −1 1 1 1 1 −1 −1 −1 1 −1 −1 −1 −1 1 −1 −1 1 |
| | −1 1 1 1 −1 −1 −1 1 −1 1 1 1 −1 1 1 −1 1 1 1 1 −1 −1 −1 1 −1 1 1 1 −1 1 1 −1 1 |
| | −1 −1 −1 1 1 1 −1 1 1 1 1 −1 1 1 −1 1 1 1 1 −1 −1 −1 1 −1 −1 −1 −1 1 −1 −1 1 |
| | −1 1 1 1 −1 −1 −1 1 −1 −1 −1 −1 1 −1 −1 1 −1 −1 −1 −1 1 1 1 −1 1 −1 −1 −1 1 |
| | −1 −1 1 −1 1 1 1 −1 −1 −1 1 −1 1 1 1 −1 1 1 −1 1 1 1 1 −1 −1 −1 1 −1 −1 −1 −1 |
| | 1 −1 −1 1 −1 1 1 1 −1 −1 −1 1 −1 1 1 1 −1 1 1 −1 1 1 1 1 −1 −1 −1 1 −1 1 1 1 −1 |
| | 1 1 −1 1 −1 −1 −1 1 1 1 −1 1 1 1 1 −1 1 1 −1 1 1 1 1 −1 −1 −1 1 −1 −1 −1 −1 1 |
| | −1 −1 1 −1 1 1 1 −1 −1 −1 1 −1 1 1 1 −1 1 1 −1 1 1 1 1 −1 −1 −1 1 −1 1 1 1 −1 1 |
| | 1 −1 1 −1 −1 −1 1 1 1 −1 1 −1 −1 −1 1 −1 −1 1 −1 −1 −1 −1 1 1 1 −1 1 1 1 1 −1 |
| | 1 1 −1 1 −1 −1 −1 1 1 1 −1 1 1 1 1 −1 1 1 −1 1 1 1 1 −1 −1 −1 1 −1 1 1 1 −1 1 1 |
| | −1 1 −1 −1 −1 1 1 1 −1 1 1 1 1 −1 1 1 −1 1 1 1 1 −1 −1 −1 1 −1 −1 −1 −1 1 −1 |
| | −1 1 −1 1 1 1 −1 −1 −1 1 −1 −1 −1 −1 1 −1 −1 1 −1 −1 −1 −1 1 1 1 −1 1 −1 −1 |
| | −1 1 −1 −1 1 −1 1 1 1 −1 −1 −1 1 −1 1 1 1 −1 1 1 −1 1 1 1 1 −1 −1 −1 1 −1 −1 |
| | −1 −1 1 −1 −1 1 1 1 1 −1 −1 −1 1 −1 1 1 1 −1 1 1 −1 1 1 1 1 −1 −1 −1 1 −1 1 |
| | 1 1 −1 1 1 −1 1 −1 −1 −1 1 1 1 −1 1 1 1 1 −1 1 1 −1 1 1 1 1 −1 −1 −1 1 −1 −1 −1 |
| | −1 1 −1 −1 1 −1 1 1 1 −1 −1 −1 1 −1 1 1 1 −1 1 1 −1 1 1 1 1 −1 −1 −1 1 −1 1 1 1 |
| | −1 1 1 −1 1 −1 −1 −1 1 1 1 −1 1 −1 −1 −1 1 −1 −1 1 −1 −1 −1 −1 1 1 1 −1 1 1 1 |
| | 1 −1 1 1 −1 1 −1 −1 −1 1 1 1 −1 1 −1 −1 −1 1 −1 −1 1 −1 −1 −1 −1 1 1 1 −1 1 −1 |
| | −1 −1 1 −1 −1 1 −1 1 1 −1 −1 −1 1 −1 −1 −1 −1 1 −1 −1 1 −1 −1 −1 −1 1 1 1 |
| | −1 1 1 1 1 −1 1 1 −1 1 −1 −1 −1 1 1 1 −1 1 1 1 1 −1 1 1 −1 1 1 1 1 −1 −1 −1 1 −1 |
| | 1 1 1 −1 1 1 −1 1 −1 −1 −1 1 1 1 −1 1 −1 −1 −1 1 −1 −1 1 −1 −1 −1 −1 1 1 1 −1 |
| | 1 1 1 1 −1 1 1 −1 1 −1 −1 −1 1 1 1 −1 1 −1 −1 −1 1 −1 −1 1 −1 −1 −1 −1 1 1 1 |
| | −1 1 −1 −1 −1 1 −1 −1 1 −1 1 1 1 −1 −1 −1 1 −1 −1 −1 −1 1 −1 −1 1 −1 −1 −1 |
| | −1 1 1 1 −1 1 1 1 1 −1 1 1 −1 1 −1 −1 −1 1 1 1 −1 1 −1 −1 −1 1 −1 −1 1 −1 −1 |
| | −1 −1 1 1 1 −1 1 −1 −1 −1 1 −1 −1 1 −1 1 1 1 −1 −1 −1 1 −1 1 1 1 −1 1 1 −1 1 1 |
| | 1 1 −1 −1 −1 1 −1 −1 −1 −1 1 −1 −1 1 −1 1 1 1 −1 −1 −1 1 −1 −1 −1 −1 1 −1 −1 |
| | 1 −1 −1 −1 −1 1 1 1 −1 1 −1 −1 −1 1 −1 −1 1 −1 1 1 1 −1 −1 −1 1 −1 −1 −1 −1 1 |
| | −1 −1 1 −1 −1 −1 −1 1 1 1 −1 1 1 1 1 −1 1 1 −1 1 −1 −1 −1 1 1 1 −1 1 1 1 1 −1 1 |
| | 1 −1 1 1 1 1 −1 −1 −1 1 −1 1 1 1 −1 1 1 −1 1 −1 −1 −1 1 1 1 −1 1 −1 −1 −1 1 −1 |
| | −1 1 −1 −1 −1 −1 1 1 1 −1 1 1 1 1 −1 1 1 −1 1 −1 −1 −1 1 1 1 −1 1 1 1 1 −1 1 1 |
| | −1 1 1 1 1 −1 −1 −1 1 −1 1 1 1 −1 1 1 −1 1 −1 −1 −1 1 1 1 −1 1 1 1 1 −1 1 1 −1 1 |
| | 1 1 1 −1 −1 −1 1 −1 −1 −1 −1 1 −1 −1 1 −1 1 1 1 −1 −1 −1 1 −1 1 1 1 −1 1 1 −1 |
| | 1 1 1 1 −1 −1 −1 1 −1 1 1 1 −1 1 1 −1 1 −1 −1 −1 1 1 1 −1 1 −1 −1 −1 1 −1 −1 1 |
| | −1 −1 −1 −1 1 1 1 −1 1 1 1 1 −1 1 1 −1 1 −1 −1 −1 1 1 1 −1 1 −1 −1 −1 1 −1 −1 |
| | 1 −1 −1 −1 −1 1 1 1 −1 1 −1 −1 −1 1 −1 −1 1 −1 1 1 1 −1 −1 −1 1 −1 −1 −1 −1 1 |
| | −1 −1 1 −1 −1 −1 −1 1 1 1 −1 1 1 1 1 −1 1 1 −1 1 −1 −1 −1 1 1 1 −1 1 1 1 1 −1 1 |
| | 1 −1 1 1 1 1 −1 −1 −1 1 −1 1 1 1 −1 1 1 −1 1 −1 −1 −1 1 1 1 −1 1 −1 −1 −1 1 −1 |
| | −1 1 −1 −1 −1 −1 1 1 1 −1 1 1 1 1 −1 1 1 −1 1 −1 −1 −1 1 1 1 −1 1 1 1 1 −1 1 1 |
| | −1 1 1 1 1 −1 −1 −1 1 −1 1 1 1 −1 1 1 −1 1 −1 −1 −1 1 1 1 −1 1 1 1 1 −1 1 1 −1 1 |
| | 1 1 1 −1 −1 −1 1 −1 −1 −1 −1 1 −1 −1 1 −1 1 1 1 −1 −1 −1 1 −1 1 1 1 −1 1 1 −1 |
| | 1 1 1 1 −1 −1 −1 1 −1 1 1 1 −1 1 1 −1 1 −1 −1 −1 1 1 1 −1 1 −1 −1 −1 1 −1 −1 1 |
| | −1 −1 −1 −1 1 1 1 −1 1 1 1 1 −1 1 1 −1 1 −1 −1 −1 1 1 1 −1 1 1 1 1 −1 1 1 −1 1 1 |
| | 1 1 −1 −1 −1 1 −1 1 1 1 −1 1 1 −1 1 −1 −1 −1 1 1 1 −1 1 1 1 1 −1 1 1 −1 1 1 1 1 |
| | −1 −1 −1 1 −1 −1 −1 −1 1 −1 −1 1 −1 1 1 1 −1 −1 −1 1 −1 −1 −1 −1 1 −1 −1 1 |
| | −1 −1 −1 −1 1 1 1 −1 1 −1 −1 −1 1 −1 −1 1 −1 1 1 1 −1 −1 −1 1 −1 1 1 1 −1 1 1 |
| | −1 1 1 1 1 −1 −1 −1 1 −1 −1 −1 −1 1 −1 −1 1 −1 1 1 1 −1 −1 −1 1 −1 1 1 1 −1 1 |
| | 1 −1 1 1 1 1 −1 −1 −1 1 −1 1 1 1 −1 1 1 −1 1 −1 −1 −1 1 1 1 −1 1 1 1 1 −1 1 1 −1 |
| | 1 1 1 1 −1 −1 −1 1 −1 −1 −1 −1 1 −1 −1 1 −1 1 1 1 −1 −1 −1 1 −1 1 1 1 −1 1 1 |
| | −1 1 1 1 1 −1 −1 −1 1 −1 1 1 1 −1 1 1 −1 1 −1 −1 −1 1 1 1 −1 1 −1 −1 −1 1 −1 |
| | −1 1 −1 −1 −1 −1 1 1 1 −1 1 1 1 1 −1 1 1 −1 1 −1 −1 −1 1 1 1 −1 1 −1 −1 −1 1 |
| | −1 −1 1 −1 −1 −1 −1 1 1 1 −1 1 −1 −1 −1 1 −1 −1 1 −1 1 1 1 −1 −1 −1 1 −1 −1 |
| | −1 −1 1 −1 −1 1 −1 −1 −1 −1 1 1 1 −1 1 1 1 1 −1 1 1 −1 1 −1 −1 −1 1 1 1 −1 1 1 |
| | 1 1 −1 1 1 −1 1 1 1 1 −1 −1 −1 1 −1 1 1 1 −1 1 1 −1 1 −1 −1 −1 1 1 1 −1 1 −1 −1 |
| | −1 1 −1 −1 1 −1 −1 −1 −1 1 1 1 −1 1 1 1 1 −1 1 1 −1 1 −1 −1 −1 1 1 1 −1 1 1 1 1 |
| | −1 1 1 −1 1 1 1 1 −1 −1 −1 1 −1 1 1 1 −1 1 1 −1 1 −1 −1 −1 1 1 1 −1 1 1 1 1 −1 1 |
| | 1 −1 1 1 1 1 −1 −1 −1 1 −1 −1 −1 −1 1 −1 −1 1 −1 1 1 1 −1 −1 −1 1 −1 1 1 1 −1 |
| | 1 1 −1 1 1 1 1 −1 −1 −1 1 −1 1 1 1 −1 1 1 −1 1 −1 −1 −1 1 1 1 −1 1 −1 −1 −1 1 |
| | −1 −1 1 −1 −1 −1 −1 1 1 1 −1 1 1 1 1 −1 1 1 −1 1 −1 −1 −1 1 1 1 −1 1 1 1 1 −1 1 |
| | 1 −1 1 1 1 1 −1 −1 −1 1 −1 1 1 1 −1 1 1 −1 1 −1 −1 −1 1 1 1 −1 1 1 1 1 −1 1 1 −1 |
| | 1 1 1 1 −1 −1 −1 1 −1 −1 −1 −1 1 −1 −1 1 −1 1 1 1 −1 −1 −1 1 −1 −1 −1 −1 1 −1 |
| | −1 1 −1 −1 −1 −1 1 1 1 −1 1 −1 −1 −1 1 −1 −1 1 −1 1 1 1 −1 −1 −1 1 −1 1 1 1 −1 |
| | 1 1 −1 1 1 1 1 −1 −1 −1 1 −1 −1 −1 −1 1 −1 −1 1 −1 1 1 1 −1 −1 −1 1 −1 −1 −1 |
| | −1 1 −1 −1 1 −1 −1 −1 −1 1 1 1 −1 1 −1 −1 −1 1 −1 −1 1 −1 1 1 1 −1 −1 −1 1 −1 |
| | −1 −1 −1 1 −1 −1 1 −1 −1 −1 −1 1 1 −1 1 1 1 1 −1 1 1 −1 1 −1 −1 −1 1 1 1 −1 |
| | 1 −1 −1 −1 1 −1 −1 1 −1 −1 −1 −1 1 1 1 −1 1 −1 −1 −1 1 −1 −1 1 −1 1 1 1 −1 −1 |
| | −1 1 −1 1 1 1 −1 1 1 −1 1 1 1 1 −1 −1 −1 1 −1 −1 −1 −1 1 −1 −1 1 −1 1 1 1 −1 |
| | −1 −1 1 −1 1 1 1 −1 1 1 −1 1 1 1 1 −1 −1 −1 1 −1 1 1 1 −1 1 1 −1 1 −1 −1 −1 1 1 |
| | 1 −1 1 1 1 1 −1 1 1 −1 1 1 1 1 −1 −1 −1 1 −1 −1 −1 −1 1 −1 −1 1 −1 1 1 1 −1 −1 |
| | −1 1 −1 −1 −1 −1 1 −1 −1 1 −1 −1 −1 −1 1 1 1 −1 1 −1 −1 −1 1 −1 −1 1 −1 1 1 1 |
| | −1 −1 −1 1 −1 1 1 1 −1 1 1 −1 1 1 1 1 −1 −1 −1 1 −1 −1 −1 −1 1 −1 −1 1 −1 1 1 |
| | 1 −1 −1 −1 1 −1 −1 −1 −1 1 −1 −1 1 −1 −1 −1 −1 1 1 1 −1 1 −1 −1 −1 1 −1 −1 1 |
| | −1 1 1 1 −1 −1 −1 1 −1 −1 −1 −1 1 −1 −1 1 −1 −1 −1 −1 1 1 1 −1 1 1 1 1 −1 1 1 |
| | −1 1 −1 −1 −1 1 1 1 −1 1 −1 −1 −1 1 −1 −1 1 −1 −1 −1 −1 1 1 1 −1 1 −1 −1 −1 1 |
| | −1 −1 1 −1 1 1 1 −1 −1 −1 1 −1 1 1 1 −1 1 1 −1 1 1 1 1 −1 −1 −1 1 −1 −1 −1 −1 |
| | 1 −1 −1 1 −1 1 1 1 −1 −1 −1 1 −1 −1 −1 −1 1 −1 −1 1 −1 −1 −1 −1 1 1 1 −1 1 −1 |
| | −1 −1 1 −1 −1 1 −1 1 1 1 −1 −1 −1 1 −1 −1 −1 −1 1 −1 −1 1 −1 −1 −1 −1 1 1 1 |
| | −1 1 1 1 1 −1 1 1 −1 1 −1 −1 −1 1 1 1 −1 1 1 1 1 −1 1 1 −1 1 1 1 1 −1 −1 −1 1 −1 |
| | 1 1 1 −1 1 1 −1 1 −1 −1 −1 1 1 1 −1 1 −1 −1 −1 1 −1 −1 1 −1 −1 −1 −1 1 1 1 −1 |
| | 1 1 1 1 −1 1 1 −1 1 −1 −1 −1 1 1 1 −1 1 −1 −1 −1 1 −1 −1 1 −1 −1 −1 −1 1 1 1 |
| | −1 1 −1 −1 −1 1 −1 −1 1 −1 1 1 1 −1 −1 −1 1 −1 −1 −1 −1 1 −1 −1 1 −1 −1 −1 |
| | −1 1 1 1 −1 1 1 1 1 −1 1 1 −1 1 −1 −1 −1 1 1 1 −1 1 −1 −1 −1 1 −1 −1 1 −1 −1 |
| | −1 −1 1 1 1 −1 1 −1 −1 −1 1 −1 −1 1 −1 1 1 1 −1 −1 −1 1 −1 1 1 1 −1 1 1 −1 1 1 |
| | 1 1 −1 −1 −1 1 −1 −1 −1 −1 1 −1 −1 1 −1 1 1 1 −1 −1 −1 1 −1 1 1 1 −1 1 1 −1 1 |
| | 1 1 1 −1 −1 −1 1 −1 1 1 1 −1 1 1 −1 1 −1 −1 −1 1 1 1 −1 1 1 1 1 −1 1 1 −1 1 1 1 |
| | 1 −1 −1 −1 1 −1 −1 −1 −1 1 −1 −1 1 −1 1 1 1 −1 −1 −1 1 −1 −1 −1 −1 1 −1 −1 1 |
| | −1 −1 −1 −1 1 1 1 −1 1 −1 −1 −1 1 −1 −1 1 −1 1 1 1 −1 −1 −1 1 −1 1 1 1 −1 1 1 |
| | −1 1 1 1 1 −1 −1 −1 1 −1 −1 −1 −1 1 −1 −1 1 −1 1 1 1 −1 −1 −1 1 −1 1 1 1 −1 1 |
| | 1 −1 1 1 1 1 −1 −1 −1 1 −1 1 1 1 −1 1 1 −1 1 −1 −1 −1 1 1 1 −1 1 1 1 1 −1 1 1 −1 |
| | 1 1 1 1 −1 −1 −1 1 −1 −1 −1 −1 1 −1 −1 1 −1 1 1 1 −1 −1 −1 1 −1 1 1 1 −1 1 1 |
| | −1 1 1 1 1 −1 −1 −1 1 −1 1 1 1 −1 1 1 −1 1 −1 −1 −1 1 1 1 −1 1 −1 −1 −1 1 −1 |
| | −1 1 −1 −1 −1 −1 1 1 1 −1 1 1 1 1 −1 1 1 −1 1 −1 −1 −1 1 1 1 −1 1 1 1 1 −1 1 1 |
| | −1 1 1 1 1 −1 −1 −1 1 −1 1 1 1 −1 1 1 −1 1 −1 −1 −1 1 1 1 −1 1 1 1 1 −1 1 1 −1 1 |
| | 1 1 1 −1 −1 −1 1 −1 −1 −1 −1 1 −1 −1 1 −1 1 1 1 −1 −1 −1 1 −1 −1 −1 −1 1 −1 |
| | −1 1 −1 −1 −1 −1 1 1 1 −1 1 −1 −1 −1 1 −1 −1 1 −1 1 1 1 −1 −1 −1 1 −1 1 1 1 −1 |
| | 1 1 −1 1 1 1 1 −1 −1 −1 1 −1 −1 −1 −1 1 −1 −1 1 −1 1 1 1 −1 −1 −1 1 −1 −1 −1 |
| | −1 1 −1 −1 1 −1 −1 −1 −1 1 1 1 −1 1 −1 −1 −1 1 −1 −1 1 −1 1 1 1 −1 −1 −1 1 −1 |
| | −1 −1 −1 1 −1 −1 1 −1 −1 −1 −1 1 1 1 −1 1 1 1 1 −1 1 1 −1 1 −1 −1 −1 1 1 1 −1 |
| | 1 −1 −1 −1 1 −1 −1 1 −1 −1 −1 −1 1 1 1 −1 1 −1 −1 −1 1 −1 −1 1 −1 1 1 1 −1 −1 |
| | −1 1 −1 1 1 1 −1 1 1 −1 1 1 1 1 −1 −1 −1 1 −1 −1 −1 −1 1 −1 −1 1 −1 1 1 1 −1 |
| | −1 −1 1 −1 1 1 1 −1 1 1 −1 1 1 1 1 −1 −1 −1 1 −1 1 1 1 −1 1 1 −1 1 −1 −1 −1 1 1 |
| | 1 −1 1 1 1 1 −1 1 1 −1 1 1 1 1 −1 −1 −1 1 −1 −1 −1 −1 1 −1 −1 1 −1 1 1 1 −1 −1 |
| | −1 1 −1 −1 −1 −1 1 −1 −1 1 −1 −1 −1 −1 1 1 1 −1 1 −1 −1 −1 1 −1 −1 1 −1 1 1 1 |
| | −1 −1 −1 1 −1 1 1 1 −1 1 1 −1 1 1 1 1 −1 −1 −1 1 −1 −1 −1 −1 1 −1 −1 1 −1 1 1 |
| | 1 −1 −1 −1 1 −1 −1 −1 −1 1 −1 −1 1 −1 −1 −1 −1 1 1 1 −1 1 −1 −1 −1 1 −1 −1 1 |
| | −1 1 1 1 −1 −1 −1 1 −1 −1 −1 −1 1 −1 −1 1 −1 −1 1 −1 1 1 −1 1 1 1 −1 1 1 |
| | −1 1 −1 −1 −1 1 1 1 −1 1 −1 −1 −1 1 −1 −1 1 −1 −1 −1 −1 1 1 1 −1 1 −1 −1 −1 1 |
| | −1 −1 1 −1 1 1 1 −1 −1 −1 1 −1 1 1 1 −1 1 1 −1 1 1 1 1 −1 −1 −1 1 −1 −1 −1 −1 |
| | 1 −1 −1 1 −1 1 1 1 −1 −1 −1 1 −1 −1 −1 −1 1 −1 −1 1 −1 −1 −1 −1 1 1 1 −1 1 −1 |
| | −1 −1 1 −1 −1 1 −1 1 1 1 −1 −1 −1 1 −1 −1 −1 −1 1 −1 −1 1 −1 −1 −1 −1 1 1 1 |
| | −1 1 1 1 1 −1 1 1 −1 1 −1 −1 −1 1 1 1 −1 1 1 1 1 −1 1 1 −1 1 1 1 1 −1 −1 −1 1 −1 |
| | 1 1 1 −1 1 1 −1 1 −1 −1 −1 1 1 1 −1 1 −1 −1 −1 1 −1 −1 1 −1 −1 −1 −1 1 1 1 −1 |
| | 1 1 1 1 −1 1 1 −1 1 −1 −1 −1 1 1 1 −1 1 −1 −1 −1 1 −1 −1 1 −1 −1 −1 −1 1 1 1 |
| | −1 1 −1 −1 −1 1 −1 −1 1 −1 1 1 1 −1 −1 −1 1 −1 −1 −1 −1 1 −1 −1 1 −1 −1 −1 |
| | −1 1 1 1 −1 1 1 1 1 −1 1 1 −1 1 −1 −1 −1 1 1 1 −1 1 −1 −1 −1 1 −1 −1 1 −1 −1 |
| | −1 −1 1 1 1 −1 1 −1 −1 −1 1 −1 −1 1 −1 1 1 1 −1 −1 −1 1 −1 1 1 1 −1 1 1 −1 1 1 |
| | 1 1 −1 −1 −1 1 −1 −1 −1 −1 1 −1 −1 1 −1 1 1 1 −1 −1 −1 1 −1 1 1 1 −1 1 1 −1 1 |
| | 1 1 1 −1 −1 −1 1 −1 1 1 1 −1 1 1 −1 1 −1 −1 −1 1 1 1 −1 1 1 1 1 −1 1 1 −1 1 1 1 |
| | 1 −1 −1 −1 1 −1 −1 −1 −1 1 −1 −1 1 −1 1 1 1 −1 −1 −1 1 −1 −1 −1 −1 1 −1 −1 1 |
| | −1 −1 −1 −1 1 1 1 −1 1 −1 −1 −1 1 −1 −1 1 −1 1 1 1 −1 −1 −1 1 −1 1 1 1 −1 1 1 |
| | −1 1 1 1 1 −1 −1 −1 1 −1 −1 −1 −1 1 −1 −1 1 −1 1 1 1 −1 −1 −1 1 −1 −1 −1 −1 1 |
| | −1 −1 1 −1 −1 −1 −1 1 1 1 −1 1 −1 −1 −1 1 −1 −1 1 −1 1 1 1 −1 −1 −1 1 −1 −1 |
| | −1 −1 1 −1 −1 1 −1 1 −1 −1 1 1 1 −1 1 1 1 1 −1 1 1 −1 1 −1 −1 1 1 1 −1 1 |
| | −1 −1 −1 1 −1 −1 1 −1 −1 −1 −1 1 1 1 −1 1 −1 −1 −1 1 −1 −1 1 −1 1 1 1 −1 −1 |
| | −1 1 −1 1 1 1 −1 1 1 −1 1 1 1 1 −1 −1 −1 1 −1 −1 −1 −1 1 −1 −1 1 −1 1 1 1 −1 |
| | −1 −1 1 −1 −1 −1 −1 1 −1 −1 1 −1 −1 −1 −1 1 1 1 −1 1 −1 −1 −1 1 −1 −1 1 −1 1 |
| | 1 1 −1 −1 −1 1 −1 −1 −1 −1 1 −1 −1 1 −1 −1 −1 −1 1 1 1 −1 1 1 1 1 −1 1 1 −1 1 |
| | −1 −1 −1 1 1 1 −1 1 1 1 1 −1 1 1 −1 1 1 1 1 −1 −1 −1 1 −1 1 1 1 −1 1 1 −1 1 −1 |
| | −1 −1 1 1 1 −1 1 −1 −1 −1 1 −1 −1 1 −1 −1 −1 −1 1 1 1 −1 1 1 1 1 −1 1 1 −1 1 |
| | −1 −1 −1 1 1 1 −1 1 1 1 1 −1 1 1 −1 1 1 1 1 −1 −1 −1 1 −1 1 1 1 −1 1 1 −1 1 −1 |
| | −1 −1 1 1 1 −1 1 1 1 1 −1 1 1 −1 1 1 1 1 −1 −1 −1 1 −1 −1 −1 −1 1 −1 −1 1 −1 1 |
| | 1 1 −1 −1 −1 1 −1 1 1 1 −1 1 1 −1 1 1 1 1 −1 −1 −1 1 −1 1 1 1 −1 1 1 −1 1 −1 −1 |
| | −1 1 1 1 −1 1 −1 −1 −1 1 −1 −1 1 −1 −1 −1 −1 1 1 1 −1 1 1 1 1 −1 1 1 −1 1 −1 |
| | −1 −1 1 1 1 −1 1 −1 −1 −1 1 −1 −1 1 −1 −1 −1 −1 1 1 1 −1 1 −1 −1 −1 1 −1 −1 1 |
| | −1 1 1 1 −1 −1 −1 1 −1 −1 −1 −1 1 −1 −1 1 −1 −1 −1 −1 1 1 1 −1 1 1 1 1 −1 1 1 |
| | −1 1 −1 −1 −1 1 1 1 −1 1 1 1 1 −1 1 1 −1 1 1 1 1 −1 −1 −1 1 −1 1 1 1 −1 1 1 −1 1 |
| | −1 −1 −1 1 1 1 −1 1 −1 −1 −1 1 −1 −1 1 −1 −1 −1 −1 1 1 1 −1 1 1 1 1 −1 1 1 −1 |
| | 1 −1 −1 −1 1 1 1 −1 1 −1 −1 −1 1 −1 −1 1 −1 −1 −1 −1 1 1 1 −1 1 −1 −1 −1 1 −1 |
| | −1 1 −1 1 1 1 −1 −1 −1 1 −1 −1 −1 −1 1 −1 −1 1 −1 −1 −1 −1 1 1 1 −1 1 1 1 1 −1 |
| | 1 1 −1 1 −1 −1 −1 1 1 1 −1 1 −1 −1 −1 1 −1 −1 1 −1 −1 −1 −1 1 1 1 −1 1 −1 −1 |
| | −1 1 −1 −1 1 −1 1 1 1 −1 −1 −1 1 −1 1 1 1 −1 1 1 −1 1 1 1 1 −1 −1 −1 1 −1 −1 |
| | −1 −1 1 −1 −1 1 −1 1 1 1 −1 −1 −1 1 −1 −1 −1 −1 1 −1 −1 1 −1 −1 −1 −1 1 1 1 |
| | −1 1 −1 −1 −1 1 −1 −1 1 −1 1 1 1 −1 −1 −1 1 −1 −1 −1 −1 1 −1 −1 1 −1 −1 −1 |
| | −1 1 1 1 −1 1 1 1 1 −1 1 1 −1 1 −1 −1 −1 1 1 1 −1 1 1 1 1 −1 1 1 −1 1 1 1 1 −1 |
| | −1 −1 1 −1 1 1 1 −1 1 1 −1 1 −1 −1 −1 1 1 1 −1 1 −1 −1 −1 1 −1 −1 1 −1 −1 −1 |
| | −1 1 1 1 −1 1 1 1 1 −1 1 1 −1 1 −1 −1 −1 1 1 1 −1 1 −1 −1 −1 1 −1 −1 1 −1 −1 |
| | −1 −1 1 1 1 −1 1 −1 −1 −1 1 −1 −1 1 −1 1 1 1 −1 −1 −1 1 −1 −1 −1 −1 1 −1 −1 1 |
| | −1 −1 −1 −1 1 1 1 −1 1 1 1 1 −1 1 1 −1 1 −1 −1 −1 1 1 1 −1 1 −1 −1 −1 1 −1 −1 |
| | 1 −1 −1 −1 −1 1 1 1 −1 1 −1 −1 −1 1 −1 −1 1 −1 1 1 1 −1 −1 −1 1 −1 1 1 1 −1 1 |
| | 1 −1 1 1 1 1 −1 −1 −1 1 −1 −1 −1 −1 1 −1 −1 1 −1 1 1 1 −1 −1 −1 1 −1 1 1 1 −1 |
| | 1 1 −1 1 1 1 1 −1 −1 −1 1 −1 1 1 1 −1 1 1 −1 1 −1 −1 −1 1 1 1 −1 1 1 1 1 −1 1 1 |
| | −1 1 1 1 1 −1 −1 −1 1 −1 −1 −1 −1 1 −1 −1 1 −1 1 1 1 −1 −1 −1 1 −1 −1 −1 −1 1 |
| | −1 −1 1 −1 −1 −1 −1 1 1 1 −1 1 −1 −1 −1 1 −1 −1 1 −1 1 1 1 −1 −1 −1 1 −1 1 1 1 |
| | −1 1 1 −1 1 1 1 1 −1 −1 −1 1 −1 −1 −1 −1 1 −1 −1 1 −1 1 1 1 −1 −1 −1 1 −1 1 1 |
| | 1 −1 1 1 −1 1 1 1 1 −1 −1 −1 1 −1 1 1 1 −1 1 1 −1 1 −1 −1 −1 1 1 1 −1 1 1 1 1 −1 |
| | 1 1 −1 1 1 1 1 −1 −1 −1 1 −1 −1 −1 −1 1 −1 −1 1 −1 1 1 1 −1 −1 −1 1 −1 1 1 1 |
| | −1 1 1 −1 1 1 1 1 −1 −1 −1 1 −1 1 1 1 −1 1 1 −1 1 −1 −1 −1 1 1 1 −1 1 −1 −1 −1 |
| | 1 −1 −1 1 −1 −1 −1 −1 1 1 1 −1 1 1 1 1 −1 1 1 −1 1 −1 −1 −1 1 1 1 −1 1 1 1 1 −1 |
| | 1 1 −1 1 1 1 1 −1 −1 −1 1 −1 1 1 1 −1 1 1 −1 1 −1 −1 −1 1 1 1 −1 1 1 1 1 −1 1 1 |
| | −1 1 1 1 1 −1 −1 −1 1 −1 −1 −1 −1 1 −1 −1 1 −1 1 1 1 −1 −1 −1 1 −1 −1 −1 −1 1 |
| | −1 −1 1 −1 −1 −1 −1 1 1 1 −1 1 −1 −1 −1 1 −1 −1 1 −1 1 1 1 −1 −1 −1 1 −1 1 1 1 |
| | −1 1 1 −1 1 1 1 1 −1 −1 −1 1 −1 −1 −1 −1 1 −1 −1 1 −1 1 1 1 −1 −1 −1 1 −1 −1 |
| | −1 −1 1 −1 −1 1 −1 −1 −1 −1 1 1 1 −1 1 −1 −1 −1 1 −1 −1 1 −1 1 1 1 −1 −1 −1 1 |
| | −1 −1 −1 −1 1 −1 −1 1 −1 −1 −1 −1 1 1 1 −1 1 1 1 1 −1 1 1 −1 1 −1 −1 −1 1 1 1 |
| | −1 1 −1 −1 −1 1 −1 −1 1 −1 −1 −1 −1 1 1 1 −1 1 −1 −1 −1 1 −1 −1 1 −1 1 1 1 −1 |
| | −1 −1 1 −1 1 1 1 −1 1 1 −1 1 1 1 1 −1 −1 −1 1 −1 −1 −1 −1 1 −1 −1 1 −1 1 1 1 |
| | −1 −1 −1 1 −1 1 1 1 −1 1 1 −1 1 1 1 1 −1 −1 −1 1 −1 1 1 1 −1 1 1 −1 1 −1 −1 −1 |
| | 1 1 1 −1 1 1 1 1 −1 1 1 −1 1 1 1 1 −1 −1 −1 1 −1 −1 −1 −1 1 −1 −1 1 −1 1 1 1 −1 |
| | −1 −1 1 −1 −1 −1 −1 1 −1 −1 1 −1 −1 −1 −1 1 1 1 −1 1 −1 −1 −1 1 −1 −1 1 −1 1 |
| | 1 1 −1 −1 −1 1 −1 1 1 1 −1 1 1 −1 1 1 1 1 −1 −1 −1 1 −1 −1 −1 −1 1 −1 −1 1 −1 |
| | 1 1 1 −1 −1 −1 1 −1 1 1 1 −1 1 1 −1 1 1 1 1 −1 −1 −1 1 −1 1 1 1 −1 1 1 −1 1 −1 |
| | −1 −1 1 1 1 −1 1 1 1 1 −1 1 1 −1 1 1 1 1 −1 −1 −1 1 −1 −1 −1 −1 1 −1 −1 1 −1 1 |
| | 1 1 −1 −1 −1 1 −1 1 1 1 −1 1 1 −1 1 1 1 1 −1 −1 −1 1 −1 1 1 1 −1 1 1 −1 1 −1 −1 |
| | −1 1 1 1 −1 1 −1 −1 −1 1 −1 −1 1 −1 −1 −1 −1 1 1 1 −1 1 1 1 1 −1 1 1 −1 1 −1 |
| | −1 −1 1 1 1 −1 1 1 1 1 −1 1 1 −1 1 1 1 1 −1 −1 −1 1 −1 1 1 1 1 1 −1 1 −1 −1 |
| | −1 1 1 1 −1 1 1 1 1 −1 1 −1 1 1 1 1 −1 −1 −1 1 −1 −1 −1 −1 1 −1 −1 1 −1 1 1 1 |
| | −1 −1 −1 1 −1 −1 −1 −1 1 −1 −1 1 −1 −1 −1 −1 1 1 1 −1 1 −1 −1 −1 1 −1 −1 1 |
| | −1 1 1 1 −1 −1 −1 1 −1 1 1 1 −1 1 1 −1 1 1 1 1 −1 −1 −1 1 −1 −1 −1 −1 1 −1 −1 |
| | 1 −1 1 1 1 −1 −1 −1 1 −1 1 1 1 −1 1 1 −1 1 1 1 1 −1 −1 −1 1 −1 1 1 1 −1 1 1 −1 1 |
| | −1 −1 −1 1 1 1 1 1 1 −1 1 1 −1 1 1 1 1 −1 −1 −1 1 −1 −1 −1 −1 1 −1 −1 1 |
| | −1 1 1 1 −1 −1 −1 1 −1 1 1 1 −1 1 1 −1 1 1 1 1 −1 −1 −1 1 −1 1 1 1 −1 1 1 −1 1 |
| | −1 −1 −1 1 1 1 −1 1 −1 −1 −1 1 −1 −1 1 −1 −1 −1 −1 1 1 1 −1 1 1 1 1 −1 1 1 −1 |
| | 1 −1 −1 −1 1 1 1 −1 1 −1 −1 −1 1 −1 −1 1 −1 −1 −1 −1 1 1 1 −1 1 −1 −1 −1 1 −1 |
| | −1 1 −1 1 1 1 −1 −1 −1 1 −1 −1 −1 −1 1 −1 −1 1 −1 −1 −1 −1 1 1 1 −1 1 1 1 1 −1 |
| | 1 1 −1 1 −1 −1 −1 1 1 1 −1 1 1 1 1 −1 1 1 −1 1 1 1 1 −1 −1 −1 1 −1 1 1 1 −1 1 1 |
| | −1 1 −1 −1 −1 1 1 1 −1 1 −1 −1 −1 1 −1 −1 1 −1 −1 −1 −1 1 1 1 −1 1 1 1 1 −1 1 |
| | 1 −1 1 −1 −1 −1 1 1 1 −1 1 1 1 1 −1 1 1 −1 1 1 1 1 −1 −1 −1 1 −1 1 1 1 −1 1 1 −1 |
| | 1 −1 −1 −1 1 1 1 −1 1 1 1 1 −1 1 1 −1 1 1 1 1 −1 −1 −1 1 −1 −1 −1 −1 1 −1 −1 1 |
| | −1 1 1 1 −1 −1 −1 1 −1 1 1 1 −1 1 1 −1 1 1 1 1 −1 −1 −1 1 −1 1 1 1 −1 1 1 −1 1 |
| | −1 −1 −1 1 1 1 −1 1 −1 −1 −1 1 −1 −1 1 −1 −1 −1 −1 1 1 1 −1 1 1 1 1 −1 1 1 −1 |
| | 1 −1 −1 −1 1 1 1 −1 1 1 1 1 −1 1 1 −1 1 1 1 1 −1 −1 −1 1 −1 1 1 1 −1 1 1 −1 1 −1 |
| | −1 −1 1 1 1 −1 1 1 1 1 −1 1 1 −1 1 1 1 1 −1 −1 −1 1 −1 −1 −1 −1 1 −1 −1 1 −1 1 |
| | 1 1 −1 −1 −1 1 −1 −1 −1 −1 1 −1 −1 1 −1 −1 −1 −1 1 1 1 −1 1 −1 −1 −1 1 −1 −1 |
| | 1 −1 1 1 1 −1 −1 −1 1 −1 1 1 1 −1 1 1 −1 1 1 1 1 −1 −1 −1 1 −1 −1 −1 −1 1 −1 |
| | −1 1 −1 1 1 1 −1 −1 −1 1 −1 −1 −1 −1 1 −1 −1 1 −1 −1 −1 −1 1 1 1 −1 1 −1 −1 |
| | −1 1 −1 −1 1 −1 1 1 1 −1 −1 −1 1 −1 −1 −1 −1 1 −1 −1 1 −1 −1 −1 −1 1 1 1 −1 1 |
| | 1 1 1 −1 1 1 −1 1 −1 −1 −1 1 1 1 −1 1 −1 −1 −1 1 −1 −1 1 −1 −1 −1 −1 1 1 1 −1 |
| | 1 −1 −1 −1 1 −1 −1 1 −1 1 1 1 −1 −1 −1 1 −1 1 1 1 −1 1 1 −1 1 1 1 1 −1 −1 −1 1 |
| | −1 −1 −1 −1 1 −1 −1 1 −1 1 1 1 −1 −1 −1 1 −1 1 1 1 −1 1 1 −1 1 1 1 1 −1 −1 −1 |
| | 1 −1 1 1 1 −1 1 1 −1 1 −1 −1 −1 1 1 1 −1 1 1 1 1 −1 1 1 −1 1 1 1 1 −1 −1 −1 1 −1 |
| | −1 −1 −1 1 −1 −1 1 −1 1 1 1 −1 −1 −1 1 −1 −1 −1 −1 1 −1 −1 1 −1 −1 −1 −1 1 1 |
| | 1 −1 1 −1 −1 −1 1 −1 −1 1 −1 1 1 1 −1 −1 −1 1 −1 1 1 1 −1 1 1 −1 1 1 1 1 −1 −1 |
| | −1 1 −1 −1 −1 −1 1 −1 −1 1 −1 1 1 1 −1 −1 −1 1 −1 −1 −1 −1 1 −1 −1 1 −1 −1 |
| | −1 −1 1 1 1 −1 1 −1 −1 −1 1 −1 −1 1 −1 1 1 1 −1 −1 −1 1 −1 −1 −1 −1 1 −1 −1 1 |
| | −1 −1 −1 −1 1 1 1 −1 1 1 1 1 −1 1 1 −1 1 −1 −1 −1 1 1 1 −1 1 −1 −1 −1 1 −1 −1 |
| | 1 −1 −1 −1 −1 1 1 1 −1 1 −1 −1 −1 1 −1 −1 1 −1 1 1 1 −1 −1 −1 1 −1 1 1 1 −1 1 |
| | 1 −1 1 1 1 1 −1 −1 −1 1 −1 −1 −1 −1 1 −1 −1 1 −1 1 1 1 −1 −1 −1 1 −1 −1 −1 −1 |
| | 1 −1 −1 1 −1 −1 −1 −1 1 1 1 −1 1 −1 −1 −1 1 −1 −1 1 −1 1 1 1 −1 −1 −1 1 −1 −1 |
| | −1 −1 1 −1 −1 1 −1 −1 −1 −1 1 1 1 −1 1 1 1 1 −1 1 1 −1 1 −1 −1 −1 1 1 1 −1 1 1 |
| | 1 1 −1 1 1 −1 1 1 1 1 −1 −1 −1 1 −1 1 1 1 −1 1 1 −1 1 −1 −1 −1 1 1 1 −1 1 −1 −1 |
| | −1 1 −1 −1 1 −1 −1 −1 −1 1 1 1 −1 1 1 1 1 −1 1 1 −1 1 −1 −1 −1 1 1 1 −1 1 −1 |
| | −1 −1 1 −1 −1 1 −1 −1 −1 −1 1 1 1 −1 1 −1 −1 −1 1 −1 −1 1 −1 1 1 1 −1 −1 −1 1 |
| | −1 −1 −1 −1 1 −1 −1 1 −1 −1 −1 −1 1 1 1 −1 1 1 1 1 −1 1 1 −1 1 −1 −1 −1 1 1 1 |
| | −1 1 −1 −1 −1 1 −1 −1 1 −1 −1 −1 −1 1 1 1 −1 1 −1 −1 −1 1 −1 −1 1 −1 1 1 1 −1 |
| | −1 −1 1 −1 1 1 1 −1 1 1 −1 1 1 1 1 −1 −1 −1 1 −1 −1 −1 −1 1 −1 −1 1 −1 1 1 1 |
| | −1 −1 −1 1 −1 1 1 1 −1 1 1 −1 1 1 1 1 −1 −1 −1 1 −1 1 1 1 −1 1 1 −1 1 −1 −1 −1 |
| | 1 1 1 −1 1 1 1 1 −1 1 1 −1 1 1 1 1 −1 −1 −1 1 −1 −1 −1 −1 1 −1 −1 1 −1 1 1 1 −1 |
| | −1 −1 1 −1 −1 −1 −1 1 −1 −1 1 −1 −1 −1 −1 1 1 1 −1 1 −1 −1 −1 1 −1 −1 1 −1 1 |
| | 1 1 −1 −1 −1 1 −1 1 1 1 −1 1 1 −1 1 1 1 1 −1 −1 −1 1 −1 −1 −1 −1 1 −1 −1 1 −1 |
| | 1 1 1 −1 −1 −1 1 −1 1 1 1 −1 1 1 −1 1 1 1 1 −1 −1 −1 1 −1 1 1 1 −1 1 1 −1 1 −1 |
| | −1 −1 1 1 1 −1 1 1 1 1 −1 1 1 −1 1 1 1 1 −1 −1 −1 1 −1 −1 −1 −1 1 −1 −1 1 −1 1 |
| | 1 1 −1 −1 −1 1 −1 1 1 1 −1 1 1 −1 1 1 1 1 −1 −1 −1 1 −1 1 1 1 −1 1 1 −1 1 −1 −1 |
| | −1 1 1 1 −1 1 −1 −1 −1 1 −1 −1 1 −1 −1 −1 −1 1 1 1 −1 1 1 1 1 −1 1 1 −1 1 −1 |
| | −1 −1 1 1 1 −1 1 1 1 1 −1 1 1 −1 1 1 1 1 −1 −1 −1 1 −1 1 1 1 −1 1 1 −1 1 −1 −1 |
| | −1 1 1 1 −1 1 1 1 1 −1 1 1 −1 1 1 1 1 −1 −1 −1 1 −1 −1 −1 −1 1 −1 −1 1 −1 1 1 1 |
| | −1 −1 −1 1 −1 −1 −1 −1 1 −1 −1 1 −1 −1 −1 −1 1 1 1 −1 1 −1 −1 −1 1 −1 −1 1 |
| | −1 1 1 1 −1 −1 −1 1 −1 1 1 1 −1 1 1 −1 1 1 1 1 −1 −1 −1 1 −1 −1 −1 −1 1 −1 −1 |
| | 1 −1 1 1 1 −1 −1 −1 1 −1 −1 −1 −1 1 −1 −1 1 −1 −1 −1 −1 1 1 1 −1 1 −1 −1 −1 1 |
| | −1 −1 1 −1 1 1 1 −1 −1 −1 1 −1 −1 −1 −1 1 −1 −1 1 −1 −1 −1 −1 1 1 1 −1 1 1 1 1 |
| | −1 1 1 −1 1 −1 −1 −1 1 1 1 −1 1 −1 −1 −1 1 −1 −1 1 −1 −1 −1 −1 1 1 1 −1 1 −1 |
| | −1 −1 1 −1 −1 1 −1 1 1 1 −1 −1 −1 1 −1 1 1 1 −1 1 1 −1 1 1 1 1 −1 −1 −1 1 −1 |
| | −1 −1 −1 1 −1 −1 1 −1 1 1 1 −1 −1 −1 1 −1 1 1 1 −1 1 1 −1 1 1 1 1 −1 −1 −1 1 |
| | −1 1 1 1 −1 1 1 −1 1 −1 −1 −1 1 1 1 −1 1 1 1 1 −1 1 1 −1 1 1 1 1 −1 −1 −1 1 −1 |
| | −1 −1 −1 1 −1 −1 1 −1 1 1 1 −1 −1 −1 1 −1 −1 −1 −1 1 −1 −1 1 −1 −1 −1 −1 1 1 |
| | 1 −1 1 −1 −1 −1 1 −1 −1 1 −1 1 1 1 −1 −1 −1 1 −1 1 1 1 −1 1 1 −1 1 1 1 1 −1 −1 |
| | −1 1 −1 −1 −1 −1 1 −1 −1 1 −1 1 1 1 −1 −1 −1 1 −1 |
| 2 | 1 1 1 −1 1 1 1 −1 1 −1 1 1 1 −1 1 1 1 1 1 −1 1 1 1 −1 −1 1 −1 −1 −1 1 −1 −1 1 1 |
| | −1 1 1 1 −1 1 1 −1 −1 −1 1 −1 −1 −1 1 1 −1 1 1 1 −1 1 −1 1 1 1 −1 1 1 1 1 1 1 −1 |
| | −1 −1 −1 1 1 −1 1 1 −1 1 −1 −1 1 1 1 −1 −1 −1 −1 1 −1 1 −1 −1 1 1 1 −1 −1 1 |
| | −1 1 1 −1 1 −1 1 1 1 1 −1 −1 −1 −1 −1 1 −1 1 1 −1 1 1 −1 −1 −1 −1 1 1 1 1 1 1 |
| | −1 −1 −1 −1 1 1 −1 1 1 −1 1 −1 −1 1 1 1 −1 −1 −1 −1 1 −1 1 −1 −1 1 −1 1 1 1 1 |
| | −1 1 −1 −1 1 −1 1 −1 −1 −1 −1 1 1 1 1 1 −1 1 −1 −1 1 −1 −1 1 1 1 1 −1 −1 −1 1 |
| | 1 1 −1 1 1 1 −1 1 −1 1 1 1 −1 1 1 1 1 1 −1 1 1 1 −1 −1 1 −1 −1 −1 1 −1 −1 −1 −1 |
| | 1 −1 −1 −1 1 −1 −1 1 1 1 −1 1 1 1 −1 −1 1 −1 −1 −1 1 −1 1 −1 −1 −1 1 −1 −1 −1 |
| | 1 1 1 −1 1 1 1 −1 1 −1 1 1 1 −1 1 1 1 1 1 −1 1 1 1 −1 −1 1 −1 −1 −1 1 −1 −1 1 1 |
| | −1 1 1 1 −1 1 1 −1 −1 −1 1 −1 −1 −1 1 1 −1 1 1 1 −1 1 −1 1 1 1 −1 1 1 1 1 1 1 −1 |
| | −1 −1 −1 1 1 −1 1 1 −1 1 −1 −1 1 1 1 −1 −1 −1 −1 1 −1 1 −1 −1 1 −1 1 1 −1 −1 1 |
| | −1 1 1 −1 1 −1 1 1 1 1 −1 −1 −1 −1 −1 1 −1 1 1 −1 1 1 −1 −1 −1 −1 1 1 1 1 1 1 |
| | −1 −1 −1 −1 1 1 −1 1 1 −1 1 −1 −1 1 1 1 −1 −1 −1 −1 1 −1 1 −1 −1 1 −1 1 1 1 1 |
| | −1 1 −1 −1 1 −1 1 −1 −1 −1 −1 1 1 1 1 1 −1 1 −1 −1 1 −1 −1 1 1 1 1 −1 −1 −1 1 |
| | 1 1 −1 1 1 1 −1 1 −1 1 1 1 −1 1 1 1 1 1 −1 1 1 1 −1 −1 1 −1 −1 −1 1 −1 −1 −1 −1 |
| | 1 −1 −1 −1 1 −1 −1 1 1 1 −1 1 1 1 −1 −1 1 −1 −1 −1 1 −1 1 −1 −1 −1 1 −1 −1 −1 |
| | 1 1 1 −1 1 1 1 −1 1 −1 1 1 1 −1 1 1 1 1 1 −1 1 1 1 −1 −1 1 −1 −1 −1 1 −1 −1 1 1 |
| | −1 1 1 1 −1 1 1 −1 −1 −1 1 −1 −1 −1 1 1 −1 1 1 1 −1 1 −1 1 1 1 −1 1 1 1 1 1 1 −1 |
| | −1 −1 −1 1 1 −1 1 1 −1 1 −1 −1 1 1 1 −1 −1 −1 −1 1 −1 1 −1 −1 1 −1 1 1 −1 −1 1 |
| | −1 1 1 −1 1 −1 1 1 1 1 −1 −1 −1 −1 −1 1 −1 1 1 −1 1 1 −1 −1 −1 −1 1 1 1 −1 −1 |
| | −1 1 1 1 1 −1 −1 1 −1 −1 1 −1 1 1 −1 −1 −1 1 1 1 1 −1 1 −1 1 1 −1 1 −1 −1 −1 |
| | −1 1 −1 1 1 −1 1 −1 1 1 1 1 −1 −1 −1 −1 −1 1 −1 1 1 −1 1 1 −1 −1 −1 −1 1 1 1 |
| | −1 −1 −1 1 −1 −1 −1 1 −1 1 −1 −1 −1 1 −1 −1 −1 −1 −1 1 −1 −1 −1 1 1 −1 1 1 1 |
| | −1 1 1 1 1 −1 1 1 1 −1 1 1 −1 −1 −1 1 −1 −1 −1 1 1 −1 1 1 1 −1 1 −1 1 1 1 −1 1 1 |
| | 1 −1 −1 −1 1 −1 −1 −1 1 −1 1 −1 −1 −1 1 −1 −1 −1 −1 −1 1 −1 −1 −1 1 1 −1 1 1 |
| | 1 −1 1 1 −1 −1 1 −1 −1 −1 1 −1 −1 1 1 1 −1 1 1 1 −1 −1 1 −1 −1 −1 1 −1 1 −1 −1 |
| | −1 1 −1 −1 −1 −1 −1 −1 1 1 1 1 −1 −1 1 −1 −1 1 −1 1 1 −1 −1 −1 1 1 1 1 −1 1 −1 |
| | 1 1 −1 1 −1 −1 1 1 −1 1 −1 −1 1 −1 1 −1 −1 −1 −1 1 1 1 1 1 −1 1 −1 −1 1 −1 −1 |
| | 1 1 1 1 −1 −1 −1 1 1 1 −1 −1 −1 −1 1 1 −1 1 1 −1 1 −1 −1 1 1 1 −1 −1 −1 −1 1 |
| | −1 1 −1 −1 1 −1 1 1 1 1 −1 1 −1 −1 1 −1 1 −1 −1 −1 −1 1 1 1 1 1 −1 1 −1 −1 1 |
| | −1 −1 1 1 1 1 −1 −1 −1 1 1 1 −1 1 1 1 −1 1 −1 1 1 1 −1 1 1 1 1 1 −1 1 1 1 −1 −1 |
| | 1 −1 −1 −1 1 −1 −1 −1 −1 1 −1 −1 −1 1 −1 −1 1 1 1 −1 1 1 1 −1 −1 1 −1 −1 −1 1 |
| | −1 1 −1 −1 −1 1 −1 −1 −1 1 1 1 −1 1 1 1 −1 1 −1 1 1 1 −1 1 1 1 1 1 −1 1 1 1 −1 |
| | −1 1 −1 −1 −1 1 −1 −1 1 1 −1 1 1 1 −1 1 1 −1 −1 −1 1 −1 −1 −1 1 1 −1 1 1 1 −1 |
| | 1 −1 1 1 1 −1 1 1 1 1 1 1 −1 −1 −1 −1 1 1 −1 1 1 −1 1 −1 −1 1 1 1 −1 −1 −1 −1 1 |
| | −1 1 −1 −1 1 −1 1 1 −1 −1 1 −1 1 1 −1 1 −1 1 1 1 1 −1 −1 −1 −1 −1 1 −1 1 1 −1 |
| | 1 1 −1 −1 −1 −1 1 1 1 1 1 1 −1 −1 −1 −1 1 1 −1 1 1 −1 1 −1 −1 1 1 1 −1 −1 −1 |
| | −1 1 −1 1 −1 −1 1 −1 1 1 1 1 −1 1 −1 −1 1 −1 1 −1 −1 −1 −1 1 1 1 1 1 −1 1 −1 |
| | −1 1 −1 −1 1 1 1 1 −1 −1 −1 1 1 1 −1 1 1 1 −1 1 −1 1 1 1 −1 1 1 1 1 1 −1 1 1 1 |
| | −1 −1 1 −1 −1 −1 1 −1 −1 −1 −1 1 −1 −1 −1 1 −1 −1 1 1 1 −1 1 1 1 −1 −1 1 −1 |
| | −1 −1 1 −1 1 −1 −1 −1 1 −1 −1 −1 −1 −1 −1 1 −1 −1 −1 1 −1 1 −1 −1 −1 1 −1 −1 |
| | −1 −1 −1 1 −1 −1 −1 1 1 −1 1 1 1 −1 1 1 −1 −1 1 −1 −1 −1 1 −1 −1 1 1 1 −1 1 1 |
| | 1 −1 −1 1 −1 −1 −1 1 −1 1 −1 −1 −1 1 −1 −1 −1 −1 −1 −1 1 1 1 1 −1 −1 1 −1 −1 |
| | 1 −1 1 1 −1 −1 −1 1 1 1 1 −1 1 −1 1 1 −1 1 −1 −1 1 1 −1 1 −1 −1 1 −1 1 −1 −1 |
| | −1 −1 1 1 1 1 1 −1 1 −1 −1 1 −1 −1 1 1 1 1 −1 −1 −1 −1 −1 −1 1 1 1 1 −1 −1 1 |
| | −1 −1 1 −1 1 1 −1 −1 −1 1 1 1 1 −1 1 −1 1 1 −1 1 −1 −1 −1 −1 1 −1 1 1 −1 1 −1 |
| | 1 1 1 1 −1 −1 −1 −1 −1 1 −1 1 1 −1 1 1 −1 −1 −1 −1 1 1 1 −1 −1 −1 1 −1 −1 −1 1 |
| | −1 1 −1 −1 −1 1 −1 −1 −1 −1 −1 1 −1 −1 −1 1 1 −1 1 1 1 −1 1 1 1 1 −1 1 1 1 −1 |
| | 1 1 −1 −1 −1 1 −1 −1 −1 1 1 −1 1 1 1 −1 1 −1 1 1 1 −1 1 1 1 1 1 1 −1 1 1 1 −1 1 |
| | −1 1 1 1 −1 1 1 1 1 1 −1 1 1 1 −1 −1 1 −1 −1 −1 1 −1 −1 1 1 −1 1 1 1 −1 1 1 −1 |
| | −1 −1 1 −1 −1 −1 1 1 −1 1 1 1 −1 1 −1 1 1 1 −1 1 1 1 1 1 1 −1 −1 1 1 −1 1 |
| | 1 −1 1 −1 −1 1 1 1 −1 −1 −1 −1 1 −1 1 −1 −1 1 −1 1 1 −1 −1 1 −1 1 1 −1 1 −1 1 |
| | 1 1 1 −1 −1 −1 −1 −1 1 −1 1 1 −1 1 1 −1 −1 −1 −1 1 1 1 −1 −1 −1 1 1 1 1 −1 −1 |
| | 1 −1 −1 1 −1 1 1 −1 −1 −1 1 1 1 1 −1 1 −1 1 1 −1 1 −1 −1 −1 −1 1 −1 1 1 −1 1 |
| | −1 1 1 1 1 −1 −1 −1 −1 −1 1 −1 1 1 −1 1 1 −1 −1 −1 −1 1 1 1 −1 −1 −1 1 −1 −1 |
| | −1 1 −1 1 −1 −1 −1 1 −1 −1 −1 −1 −1 1 −1 −1 −1 1 1 −1 1 1 1 −1 1 1 1 1 −1 1 1 |
| | 1 −1 1 1 −1 −1 −1 1 −1 −1 −1 1 1 −1 1 1 1 −1 1 −1 1 1 1 −1 1 1 1 1 1 1 −1 1 1 1 |
| | −1 1 −1 1 1 1 −1 1 1 1 1 1 −1 1 1 1 −1 −1 1 −1 −1 −1 1 −1 −1 1 1 −1 1 1 1 −1 1 1 |
| | −1 −1 −1 1 −1 −1 −1 1 1 −1 1 1 1 −1 1 −1 1 1 1 −1 1 1 1 1 1 1 −1 −1 −1 −1 1 1 |
| | −1 1 1 −1 1 −1 −1 1 1 1 −1 −1 −1 −1 1 −1 1 −1 −1 1 −1 1 1 −1 −1 1 −1 1 1 −1 1 |
| | −1 1 1 1 1 −1 −1 −1 −1 −1 1 −1 1 1 −1 1 1 −1 −1 −1 −1 1 1 1 −1 −1 −1 1 1 1 1 |
| | −1 −1 1 −1 −1 1 −1 1 1 −1 −1 −1 1 1 1 1 −1 1 −1 1 1 −1 1 −1 −1 −1 −1 1 −1 1 1 |
| | −1 1 −1 1 1 1 1 −1 −1 −1 −1 −1 1 −1 1 1 −1 1 1 −1 −1 −1 −1 1 1 1 −1 −1 −1 1 −1 |
| | −1 −1 1 −1 1 −1 −1 −1 1 −1 −1 −1 −1 −1 1 −1 −1 −1 1 1 −1 1 1 1 −1 1 1 1 1 −1 1 |
| | 1 1 −1 1 1 −1 −1 −1 1 −1 −1 −1 1 1 −1 1 1 1 −1 1 −1 1 1 1 −1 1 1 1 1 1 1 −1 1 1 |
| | 1 −1 1 −1 1 1 1 −1 1 1 1 1 1 −1 1 1 1 −1 −1 1 −1 −1 −1 1 −1 −1 1 1 −1 1 1 1 −1 1 |
| | 1 −1 −1 −1 1 −1 −1 −1 1 1 −1 1 1 1 −1 1 −1 1 1 1 −1 1 1 1 1 1 1 −1 −1 −1 −1 1 1 |
| | −1 1 1 −1 1 −1 −1 1 1 1 −1 −1 −1 −1 1 −1 1 −1 −1 1 −1 1 1 −1 −1 1 −1 1 1 −1 1 |
| | −1 1 1 1 1 −1 −1 −1 −1 −1 1 −1 1 1 −1 1 1 −1 −1 −1 −1 1 1 1 1 1 1 −1 −1 −1 −1 |
| | 1 1 −1 1 1 −1 1 −1 −1 1 1 1 −1 −1 −1 −1 1 −1 1 −1 −1 1 −1 1 1 1 1 −1 1 −1 −1 1 |
| | −1 1 −1 −1 −1 −1 1 1 1 1 1 −1 1 −1 −1 1 −1 −1 1 1 1 1 −1 −1 −1 1 1 1 −1 1 1 1 |
| | −1 1 −1 1 1 1 −1 1 1 1 1 1 −1 1 1 1 −1 −1 1 −1 −1 −1 1 −1 −1 −1 −1 1 −1 −1 −1 |
| | 1 −1 −1 1 1 1 −1 1 1 1 −1 −1 1 −1 −1 −1 1 −1 1 −1 −1 −1 1 −1 −1 −1 1 1 1 −1 1 |
| | 1 1 −1 1 −1 1 1 1 −1 1 1 1 1 1 −1 1 1 1 −1 −1 1 −1 −1 −1 1 −1 −1 1 1 −1 1 1 1 −1 |
| | 1 1 −1 −1 −1 1 −1 −1 −1 1 1 −1 1 1 1 −1 1 −1 1 1 1 −1 1 1 1 1 1 1 −1 −1 −1 −1 1 |
| | 1 −1 1 1 −1 1 −1 −1 1 1 1 −1 −1 −1 −1 1 −1 1 −1 −1 1 −1 1 1 −1 −1 1 −1 1 1 −1 |
| | 1 −1 1 1 1 1 −1 −1 −1 −1 −1 1 −1 1 1 −1 1 1 −1 −1 −1 −1 1 1 1 1 1 1 −1 −1 −1 |
| | −1 1 1 −1 1 1 −1 1 −1 −1 1 1 1 −1 −1 −1 −1 1 −1 1 −1 −1 1 1 1 1 1 1 −1 1 −1 |
| | −1 1 −1 1 −1 −1 −1 −1 1 1 1 1 1 −1 1 −1 −1 1 −1 −1 1 1 1 1 −1 −1 −1 1 1 1 −1 1 |
| | 1 1 −1 1 −1 1 1 1 −1 1 1 1 1 1 −1 1 1 1 −1 −1 1 −1 −1 −1 1 −1 −1 −1 −1 1 −1 −1 |
| | −1 1 −1 −1 1 1 1 −1 1 1 1 −1 −1 1 −1 −1 −1 1 −1 1 −1 −1 −1 1 −1 −1 −1 1 1 1 −1 |
| | 1 1 1 −1 1 −1 1 1 1 −1 1 1 1 1 1 −1 1 1 1 −1 −1 1 −1 −1 −1 1 −1 −1 1 1 −1 1 1 1 |
| | −1 1 1 −1 −1 −1 1 −1 −1 −1 1 1 −1 1 1 1 −1 1 −1 1 1 1 −1 1 1 1 1 1 1 −1 −1 −1 |
| | −1 1 1 −1 1 1 −1 1 −1 −1 1 1 1 −1 −1 −1 −1 1 −1 1 −1 −1 1 −1 1 1 −1 −1 1 −1 1 |
| | 1 −1 1 −1 1 1 1 1 −1 −1 −1 −1 −1 1 −1 1 1 −1 1 1 −1 −1 −1 1 1 1 1 −1 −1 −1 1 |
| | 1 1 1 −1 −1 1 1 −1 1 −1 1 1 −1 −1 −1 1 1 1 1 −1 1 −1 1 1 −1 1 −1 −1 −1 −1 1 |
| | −1 1 1 −1 1 −1 1 1 1 1 −1 −1 −1 −1 −1 1 −1 1 1 −1 1 1 −1 −1 −1 −1 1 1 1 −1 −1 |
| | −1 1 −1 −1 −1 1 −1 1 −1 −1 −1 1 −1 −1 −1 −1 −1 1 −1 −1 −1 1 1 −1 1 1 1 −1 1 1 |
| | 1 1 −1 1 1 1 −1 1 1 −1 −1 −1 1 −1 −1 −1 1 1 −1 1 1 1 −1 1 −1 1 1 1 −1 1 1 1 −1 |
| | −1 −1 1 −1 −1 −1 1 −1 1 −1 −1 −1 1 −1 −1 −1 −1 −1 1 −1 −1 −1 1 1 −1 1 1 1 −1 |
| | 1 1 −1 −1 1 −1 −1 −1 1 −1 −1 1 1 1 −1 1 1 1 −1 −1 1 −1 −1 −1 1 −1 1 −1 −1 −1 1 |
| | −1 −1 −1 −1 −1 −1 1 1 1 1 −1 −1 1 −1 −1 1 −1 1 1 −1 −1 −1 1 1 1 1 −1 1 −1 1 1 |
| | −1 1 −1 −1 1 1 −1 1 −1 −1 1 −1 1 −1 −1 −1 −1 1 1 1 1 1 −1 1 −1 −1 1 −1 −1 1 1 |
| | 1 1 −1 −1 1 1 1 −1 −1 −1 1 1 −1 1 1 −1 1 −1 −1 1 1 1 −1 −1 −1 −1 1 −1 1 |
| | −1 −1 1 −1 1 1 1 1 −1 1 −1 −1 1 −1 1 −1 −1 −1 −1 1 1 1 1 1 −1 1 −1 −1 1 −1 −1 |
| | 1 1 1 1 −1 −1 −1 1 1 1 −1 1 1 1 −1 1 −1 1 1 1 −1 1 1 1 1 1 −1 1 1 1 −1 −1 1 −1 |
| | −1 −1 1 −1 −1 −1 −1 1 −1 −1 −1 1 −1 −1 1 1 1 −1 1 1 1 −1 −1 1 −1 −1 −1 1 −1 1 |
| | −1 −1 −1 1 −1 −1 −1 −1 −1 −1 1 −1 −1 −1 1 −1 1 −1 −1 −1 1 −1 −1 −1 −1 −1 1 |
| | −1 −1 −1 1 1 −1 1 1 1 −1 1 1 −1 −1 1 −1 −1 −1 1 −1 −1 1 1 1 −1 1 1 1 −1 −1 1 |
| | −1 −1 −1 1 −1 1 −1 −1 −1 1 −1 −1 −1 −1 −1 −1 1 1 1 1 −1 −1 1 −1 −1 1 −1 1 1 |
| | −1 −1 −1 1 1 1 1 −1 1 −1 1 1 −1 1 −1 −1 1 1 −1 1 −1 −1 1 −1 1 −1 −1 −1 −1 1 1 |
| | 1 1 1 −1 1 −1 −1 1 −1 −1 1 1 1 1 −1 −1 −1 −1 −1 −1 1 1 1 1 −1 −1 1 −1 −1 1 −1 |
| | 1 1 −1 −1 −1 1 1 1 1 −1 1 −1 1 1 −1 1 −1 −1 −1 −1 1 −1 1 1 −1 1 1 1 1 1 −1 |
| | −1 −1 −1 −1 1 −1 1 1 −1 1 1 −1 1 −1 −1 1 1 1 −1 −1 −1 1 −1 −1 −1 1 −1 1 −1 |
| | −1 −1 1 −1 −1 −1 −1 −1 1 −1 −1 −1 1 1 −1 1 1 1 −1 1 1 1 1 −1 1 1 1 −1 1 1 −1 |
| | −1 −1 1 −1 −1 −1 1 1 −1 1 1 1 −1 1 −1 1 1 1 −1 1 1 1 1 1 1 −1 1 1 1 −1 1 −1 1 1 |
| | 1 −1 1 1 1 1 1 −1 1 1 1 −1 −1 1 −1 −1 −1 1 −1 −1 1 1 −1 1 1 1 −1 1 1 −1 −1 −1 1 |
| | −1 −1 −1 1 1 −1 1 1 1 −1 1 −1 1 1 1 −1 1 1 1 1 1 1 −1 −1 −1 −1 1 1 −1 1 1 −1 1 |
| | −1 −1 1 1 1 −1 −1 −1 −1 1 −1 1 −1 −1 1 −1 1 1 −1 −1 1 −1 1 1 −1 1 −1 1 1 1 1 |
| | −1 −1 −1 −1 −1 1 −1 1 1 −1 1 1 −1 −1 −1 −1 1 1 1 1 1 1 −1 −1 −1 −1 1 1 −1 1 1 |
| | −1 1 −1 −1 1 1 1 −1 −1 −1 −1 1 −1 1 −1 −1 1 −1 1 1 1 1 −1 1 −1 −1 1 −1 1 −1 −1 |
| | −1 −1 1 1 1 1 1 −1 1 −1 −1 1 −1 1 1 1 1 −1 −1 1 1 1 −1 1 1 1 −1 1 −1 1 1 1 |
| | −1 1 1 1 1 1 −1 1 1 1 −1 −1 1 −1 −1 −1 1 −1 −1 −1 −1 1 −1 −1 −1 1 −1 −1 1 1 1 |
| | −1 1 1 1 −1 −1 1 −1 −1 −1 1 −1 1 −1 −1 −1 1 −1 −1 −1 −1 −1 −1 1 −1 −1 −1 1 |
| | −1 1 −1 −1 −1 1 −1 −1 −1 −1 −1 1 −1 −1 −1 1 1 −1 1 1 1 −1 1 1 −1 −1 1 −1 −1 |
| | −1 1 −1 −1 1 1 1 −1 1 1 1 −1 −1 1 −1 −1 −1 1 −1 1 −1 −1 −1 1 −1 −1 −1 −1 −1 |
| | −1 1 1 1 1 −1 −1 1 −1 −1 1 −1 1 1 −1 −1 −1 1 1 1 1 −1 1 −1 1 1 −1 1 −1 −1 1 1 |
| | −1 1 −1 −1 1 −1 1 −1 −1 −1 −1 1 1 1 1 1 −1 1 −1 −1 1 −1 −1 1 1 1 1 −1 −1 −1 1 |
| | 1 1 −1 −1 −1 −1 1 1 −1 1 1 −1 1 −1 −1 1 1 1 −1 −1 −1 −1 1 −1 1 −1 −1 1 −1 1 1 |
| | 1 1 −1 1 −1 −1 1 −1 1 −1 −1 −1 −1 1 1 1 1 1 −1 1 −1 −1 1 −1 −1 1 1 1 1 −1 −1 |
| | −1 1 1 1 −1 1 1 1 −1 1 −1 1 1 1 −1 1 1 1 1 1 −1 1 1 1 −1 −1 1 −1 −1 −1 1 −1 −1 |
| | −1 −1 1 −1 −1 −1 1 −1 −1 1 1 1 −1 1 1 1 −1 −1 1 −1 −1 −1 1 −1 1 −1 −1 −1 1 −1 |
| | −1 −1 −1 −1 −1 1 −1 −1 −1 1 −1 1 −1 −1 −1 1 −1 −1 −1 −1 −1 1 −1 −1 −1 1 1 −1 |
| | 1 1 1 −1 1 1 −1 −1 1 −1 −1 −1 1 −1 −1 1 1 1 −1 1 1 1 −1 −1 1 −1 −1 −1 1 −1 1 |
| | −1 −1 −1 1 −1 −1 −1 −1 −1 −1 1 1 1 1 −1 −1 1 −1 −1 1 −1 1 1 −1 −1 −1 1 1 1 1 |
| | −1 1 −1 1 1 −1 1 −1 −1 1 1 −1 1 −1 −1 1 −1 1 −1 −1 −1 −1 1 1 1 1 1 −1 1 −1 −1 |
| | 1 −1 −1 1 1 1 1 −1 −1 −1 1 1 1 −1 −1 −1 −1 1 1 −1 1 1 −1 1 −1 −1 1 1 1 −1 −1 |
| | −1 −1 1 −1 1 −1 −1 1 −1 1 1 1 1 −1 1 −1 −1 1 −1 1 −1 −1 −1 −1 1 1 1 1 1 −1 1 |
| | −1 −1 1 −1 −1 1 1 1 1 −1 −1 −1 1 1 1 −1 1 1 1 −1 1 −1 1 1 1 −1 1 1 1 1 1 −1 1 1 |
| | 1 −1 −1 1 −1 −1 −1 1 −1 −1 −1 −1 1 −1 −1 −1 1 −1 −1 1 1 1 −1 1 1 1 −1 −1 1 −1 |
| | −1 −1 1 −1 1 −1 −1 −1 1 −1 −1 −1 −1 −1 −1 1 −1 −1 −1 1 −1 1 −1 −1 −1 1 −1 −1 |
| | −1 −1 −1 1 −1 −1 −1 1 1 −1 1 1 1 −1 1 1 −1 −1 1 −1 −1 −1 1 −1 −1 1 1 1 −1 1 1 |
| | 1 −1 −1 1 −1 −1 −1 1 −1 1 −1 −1 −1 1 −1 −1 −1 −1 −1 −1 1 1 1 1 −1 −1 1 −1 −1 |
| | 1 −1 1 1 −1 −1 −1 1 1 1 1 −1 1 −1 1 1 −1 1 −1 −1 1 1 −1 1 −1 −1 1 −1 1 −1 −1 |
| | −1 −1 1 1 1 1 1 −1 1 −1 −1 1 −1 1 1 1 1 1 −1 −1 −1 −1 −1 1 1 1 1 1 −1 −1 1 |
| | −1 −1 1 −1 1 1 1 −1 −1 1 1 1 1 −1 1 −1 1 1 −1 1 −1 −1 −1 −1 1 −1 1 1 −1 1 −1 |
| | 1 1 1 1 −1 −1 −1 −1 −1 1 −1 1 1 −1 1 1 −1 −1 −1 −1 1 1 1 −1 −1 −1 1 −1 −1 −1 1 |
| | −1 1 −1 −1 −1 1 −1 −1 −1 −1 −1 1 −1 −1 −1 1 1 −1 1 1 1 −1 1 1 1 1 −1 1 1 1 −1 |
| | 1 1 −1 −1 −1 1 −1 −1 −1 1 1 −1 1 1 1 −1 1 −1 1 1 1 −1 1 1 1 −1 −1 −1 1 −1 −1 |
| | −1 1 −1 1 −1 −1 −1 1 −1 −1 −1 −1 −1 1 −1 −1 −1 1 1 −1 1 1 1 −1 1 1 −1 −1 1 −1 |
| | −1 −1 1 −1 −1 1 1 1 −1 1 1 1 −1 −1 1 −1 −1 −1 1 −1 1 −1 −1 −1 1 −1 −1 −1 −1 |
| | −1 −1 1 1 1 1 −1 −1 1 −1 −1 1 −1 1 1 −1 −1 −1 1 1 1 1 −1 1 −1 1 1 −1 1 −1 −1 1 |
| | 1 −1 1 −1 −1 1 −1 1 −1 −1 −1 −1 1 1 1 1 1 −1 1 −1 −1 1 −1 −1 1 1 1 1 −1 −1 −1 |
| | −1 −1 −1 1 1 1 1 −1 −1 1 −1 −1 1 −1 1 1 −1 −1 −1 1 1 1 1 −1 1 −1 1 1 −1 1 −1 |
| | −1 −1 −1 1 −1 1 1 −1 1 −1 1 1 1 1 −1 −1 −1 −1 −1 1 −1 1 1 −1 1 1 −1 −1 −1 −1 1 |
| | 1 1 −1 −1 −1 1 −1 −1 −1 1 −1 1 −1 −1 −1 1 −1 −1 −1 −1 −1 1 −1 −1 −1 1 1 −1 1 |
| | 1 1 −1 1 1 1 1 −1 1 1 1 −1 1 1 −1 −1 −1 1 −1 −1 −1 1 1 −1 1 1 1 −1 1 −1 1 1 1 −1 |
| | 1 1 1 −1 −1 −1 1 −1 −1 −1 1 −1 1 −1 −1 −1 1 −1 −1 −1 −1 −1 1 −1 −1 −1 1 1 −1 |
| | 1 1 1 −1 1 1 −1 −1 1 −1 −1 −1 1 −1 −1 1 1 1 −1 1 1 1 −1 −1 1 −1 −1 −1 1 −1 1 |
| | −1 −1 −1 1 −1 −1 −1 −1 −1 −1 1 1 1 1 −1 −1 1 −1 −1 1 −1 1 1 −1 −1 −1 1 1 1 1 |
| | −1 1 −1 1 1 −1 1 −1 −1 1 1 −1 1 −1 −1 1 −1 1 −1 −1 −1 −1 1 1 1 1 1 −1 1 −1 −1 |
| | 1 −1 −1 1 1 1 1 −1 −1 −1 1 1 1 −1 −1 −1 −1 1 1 −1 1 1 −1 1 −1 −1 1 1 1 −1 −1 |
| | −1 −1 1 −1 1 −1 −1 1 −1 1 1 1 1 −1 1 −1 −1 1 −1 1 −1 −1 −1 −1 1 1 1 1 1 −1 1 |
| | −1 −1 1 −1 −1 1 1 1 1 −1 −1 −1 1 1 1 −1 1 1 1 −1 1 −1 1 1 1 −1 1 1 1 1 1 −1 1 1 |
| | 1 −1 −1 1 −1 −1 −1 1 −1 −1 −1 −1 1 −1 −1 −1 1 −1 −1 1 1 1 −1 1 1 1 −1 −1 1 −1 |
| | −1 −1 1 −1 1 −1 −1 −1 1 −1 −1 −1 1 1 1 −1 1 1 1 −1 1 −1 1 1 1 −1 1 1 1 1 1 −1 1 |
| | 1 1 −1 −1 1 −1 −1 −1 1 −1 −1 1 1 −1 1 1 1 −1 1 1 −1 −1 −1 1 −1 −1 −1 1 1 −1 1 |
| | 1 1 −1 1 −1 1 1 1 −1 1 1 1 1 1 1 −1 −1 −1 −1 1 1 −1 1 1 −1 1 −1 −1 1 1 1 −1 −1 |
| | −1 −1 1 −1 1 −1 −1 1 −1 1 1 −1 −1 1 −1 1 1 −1 1 −1 1 1 1 1 −1 −1 −1 −1 −1 1 −1 |
| | 1 1 −1 1 1 −1 −1 −1 −1 1 1 1 −1 −1 −1 1 1 1 1 −1 −1 1 −1 −1 1 −1 1 1 −1 −1 −1 |
| | 1 1 1 1 −1 1 −1 1 1 −1 1 −1 −1 −1 −1 1 −1 1 1 −1 1 −1 1 1 1 1 −1 −1 −1 −1 −1 1 |
| | −1 1 1 −1 1 1 −1 −1 −1 −1 1 1 1 −1 −1 −1 1 −1 −1 −1 1 −1 1 −1 −1 −1 1 −1 −1 |
| | −1 −1 −1 1 −1 −1 −1 1 1 −1 1 1 1 −1 1 1 1 1 −1 1 1 1 −1 1 1 −1 −1 −1 1 −1 −1 |
| | −1 1 1 −1 1 1 1 −1 1 −1 1 1 1 −1 1 1 1 −1 −1 −1 1 −1 −1 −1 1 −1 1 −1 −1 −1 1 |
| | −1 −1 −1 −1 −1 1 −1 −1 −1 1 1 −1 1 1 1 −1 1 1 −1 −1 1 −1 −1 −1 1 −1 −1 1 1 1 |
| | −1 1 1 1 −1 −1 1 −1 −1 −1 1 −1 1 −1 −1 −1 1 −1 −1 −1 −1 −1 −1 1 1 1 1 −1 −1 1 |
| | −1 −1 1 −1 1 1 −1 −1 −1 1 1 1 1 −1 1 −1 1 1 −1 1 −1 −1 1 1 −1 1 −1 −1 1 −1 1 |
| | −1 −1 −1 −1 1 1 1 1 1 −1 1 −1 −1 1 −1 −1 1 1 1 1 −1 −1 −1 −1 −1 −1 1 1 1 1 −1 |
| | −1 1 −1 −1 1 −1 1 1 −1 −1 −1 1 1 1 1 −1 1 −1 1 1 −1 1 −1 −1 −1 −1 1 −1 1 1 −1 |
| | 1 −1 1 1 1 1 −1 −1 −1 −1 −1 1 −1 1 1 −1 1 1 −1 −1 −1 −1 1 1 1 −1 −1 −1 1 −1 −1 |
| | −1 1 −1 1 −1 −1 −1 1 −1 −1 −1 −1 −1 1 −1 −1 −1 1 1 −1 1 1 1 −1 1 1 1 1 −1 1 1 |
| | 1 −1 1 1 −1 −1 −1 1 −1 −1 −1 1 1 −1 1 1 1 −1 1 −1 1 1 1 −1 1 1 1 1 1 1 −1 1 1 1 |
| | −1 1 −1 1 1 1 −1 1 1 1 1 1 −1 1 1 1 −1 −1 1 −1 −1 −1 1 −1 −1 1 1 −1 1 1 1 −1 1 1 |
| | −1 −1 −1 1 −1 −1 −1 1 1 −1 1 1 1 −1 1 −1 1 1 1 −1 1 1 1 1 1 1 −1 −1 −1 −1 1 1 |
| | −1 1 1 −1 1 −1 −1 1 1 1 −1 −1 −1 −1 1 −1 1 −1 −1 1 −1 1 1 −1 −1 1 −1 1 1 −1 1 |
| | −1 1 1 1 1 −1 −1 −1 −1 −1 1 −1 1 1 −1 1 1 −1 −1 −1 −1 1 1 1 1 1 1 −1 −1 −1 −1 |
| | 1 1 −1 1 1 −1 1 −1 −1 1 1 1 −1 −1 −1 −1 1 −1 1 −1 −1 1 −1 1 1 1 1 −1 1 −1 −1 1 |
| | −1 1 −1 −1 −1 −1 1 1 1 1 1 −1 1 −1 −1 1 −1 −1 1 1 1 1 −1 −1 −1 1 1 1 −1 1 1 1 |
| | −1 1 −1 1 1 1 −1 1 1 1 1 1 −1 1 1 1 −1 −1 1 −1 −1 −1 1 −1 −1 −1 −1 1 −1 −1 −1 |
| | 1 −1 −1 1 1 1 −1 1 1 1 −1 −1 1 −1 −1 −1 1 −1 1 −1 −1 −1 1 −1 −1 −1 −1 −1 −1 1 |
| | −1 −1 −1 1 −1 1 −1 −1 −1 1 −1 −1 −1 −1 −1 1 −1 −1 −1 1 1 −1 1 1 1 −1 1 1 −1 |
| | −1 1 −1 −1 −1 1 −1 −1 1 1 1 −1 1 1 1 −1 −1 1 −1 −1 −1 1 −1 1 −1 −1 −1 1 −1 −1 |
| | −1 −1 −1 −1 1 1 1 1 −1 −1 1 −1 −1 1 −1 1 1 −1 −1 −1 1 1 1 1 −1 1 −1 1 1 −1 1 |
| | −1 −1 1 1 −1 1 −1 −1 1 −1 1 −1 −1 −1 −1 1 1 1 1 1 −1 1 −1 −1 1 −1 −1 1 1 1 1 |
| | −1 −1 −1 1 1 1 −1 −1 −1 −1 1 1 −1 1 1 −1 1 −1 −1 1 1 1 −1 −1 −1 −1 1 −1 1 −1 |
| | −1 1 −1 1 1 1 1 −1 1 −1 −1 1 −1 1 −1 −1 −1 −1 1 1 1 1 1 −1 1 −1 −1 1 −1 −1 1 1 |
| | 1 1 −1 −1 −1 1 1 1 −1 1 1 1 −1 1 −1 1 1 1 −1 1 1 1 1 1 −1 1 1 1 −1 −1 1 −1 −1 −1 |
| | 1 −1 −1 −1 −1 1 −1 −1 −1 1 −1 −1 1 1 1 −1 1 1 1 −1 −1 −1 −1 1 −1 1 −1 −1 |
| | −1 1 −1 −1 −1 −1 −1 −1 1 −1 −1 −1 1 −1 1 −1 −1 −1 1 −1 −1 −1 −1 −1 1 −1 −1 |
| | −1 1 1 −1 1 1 1 −1 1 1 −1 −1 1 −1 −1 −1 1 −1 −1 1 1 1 −1 1 1 1 −1 −1 1 −1 −1 |
| | −1 1 −1 1 −1 −1 −1 1 −1 −1 −1 −1 −1 −1 1 1 1 1 −1 1 −1 1 −1 1 1 −1 −1 |
| | −1 1 1 1 1 −1 1 −1 1 1 −1 1 −1 −1 1 1 −1 1 −1 −1 1 −1 1 −1 −1 −1 −1 1 1 1 1 1 |
| | −1 1 −1 −1 1 −1 −1 1 1 1 1 −1 −1 −1 1 1 1 −1 −1 −1 −1 1 1 −1 1 1 −1 1 −1 −1 1 |
| | 1 1 −1 −1 −1 −1 1 −1 1 −1 −1 1 −1 1 1 1 1 −1 1 −1 −1 1 −1 1 −1 −1 −1 −1 1 1 1 |
| | 1 1 −1 1 −1 −1 1 −1 −1 1 1 1 1 −1 −1 −1 1 1 1 −1 1 1 1 −1 1 −1 1 1 1 −1 1 1 1 1 |
| | 1 −1 1 1 1 −1 −1 1 −1 −1 −1 1 −1 −1 −1 −1 1 −1 −1 −1 1 −1 −1 1 1 1 −1 1 1 1 −1 |
| | −1 1 −1 −1 −1 1 −1 1 −1 −1 −1 1 −1 −1 −1 1 1 1 −1 1 1 1 −1 1 −1 1 1 1 −1 1 1 1 |
| | 1 1 −1 1 1 1 −1 −1 1 −1 −1 −1 1 −1 −1 1 1 −1 1 1 1 −1 1 1 −1 −1 −1 1 −1 −1 −1 |
| | 1 1 −1 1 1 1 −1 1 −1 1 1 1 −1 1 1 1 1 1 1 −1 −1 −1 −1 1 1 −1 1 1 −1 1 −1 −1 1 1 |
| | 1 −1 −1 −1 −1 1 −1 1 −1 −1 1 −1 1 1 −1 −1 1 −1 1 1 −1 1 −1 1 1 1 1 −1 −1 −1 −1 |
| | −1 1 −1 1 1 −1 1 1 −1 −1 −1 −1 1 1 1 1 1 1 −1 −1 −1 −1 1 1 −1 1 1 −1 1 −1 −1 1 |
| | 1 1 −1 −1 −1 −1 1 −1 1 −1 −1 1 −1 1 1 1 1 −1 1 −1 −1 1 −1 1 −1 −1 −1 −1 1 1 1 |
| | 1 1 −1 1 −1 −1 1 −1 −1 1 1 1 1 −1 −1 −1 1 1 1 1 1 −1 1 −1 1 1 1 −1 1 1 1 1 |
| | 1 −1 1 1 1 −1 −1 1 −1 −1 −1 1 −1 −1 −1 −1 1 −1 −1 −1 1 −1 −1 1 1 1 −1 1 1 1 −1 |
| | −1 1 −1 −1 −1 1 −1 1 −1 −1 −1 1 −1 −1 −1 1 1 1 −1 1 1 1 −1 1 −1 1 1 1 −1 1 1 1 |
| | 1 1 −1 1 1 1 −1 −1 1 −1 −1 −1 1 −1 −1 1 1 1 −1 1 1 −1 −1 −1 1 −1 −1 −1 |
| | 1 1 −1 1 1 1 −1 1 −1 1 1 1 −1 1 1 1 1 1 1 −1 −1 −1 −1 1 1 −1 1 1 −1 1 −1 −1 1 1 |
| | 1 −1 −1 −1 −1 1 −1 1 −1 −1 1 −1 1 1 −1 −1 1 −1 1 1 −1 1 −1 1 1 1 1 −1 −1 −1 −1 |
| | −1 1 −1 1 1 −1 1 1 −1 −1 −1 −1 1 1 1 1 1 1 −1 −1 −1 −1 1 1 −1 1 1 −1 1 −1 −1 1 |
| | 1 1 −1 −1 −1 −1 1 −1 1 −1 −1 1 −1 1 1 1 1 −1 1 −1 −1 1 −1 1 −1 −1 −1 −1 1 1 1 |
| | 1 1 −1 1 −1 −1 1 −1 −1 1 1 1 1 −1 −1 −1 1 1 1 −1 1 1 1 −1 1 −1 1 1 1 −1 1 1 1 1 |
| | 1 −1 1 1 1 −1 −1 1 −1 −1 −1 1 −1 −1 −1 −1 1 −1 −1 −1 1 −1 −1 1 1 1 −1 1 1 1 −1 |
| | −1 1 −1 −1 −1 1 −1 1 −1 −1 −1 1 −1 −1 −1 1 1 1 −1 1 1 1 −1 1 −1 1 1 1 −1 1 1 1 |
| | 1 1 −1 1 1 1 −1 −1 1 −1 −1 −1 1 −1 −1 1 1 −1 1 1 1 −1 1 1 −1 −1 −1 1 −1 −1 −1 |
| | 1 1 −1 1 1 1 −1 1 −1 1 1 1 −1 1 1 1 1 1 1 −1 −1 −1 −1 1 1 −1 1 1 −1 1 −1 −1 1 1 |
| | 1 −1 −1 −1 −1 1 −1 1 −1 −1 1 −1 1 1 −1 −1 1 −1 1 1 −1 1 −1 1 1 1 1 −1 −1 −1 −1 |
| | −1 1 −1 1 1 −1 1 1 −1 −1 −1 −1 1 1 1 −1 −1 −1 1 1 1 1 −1 −1 1 −1 −1 1 −1 1 1 |
| | −1 −1 −1 1 1 1 1 −1 1 −1 1 1 −1 1 −1 −1 −1 −1 1 −1 1 1 −1 1 −1 1 1 1 1 −1 −1 |
| | −1 −1 −1 1 −1 1 1 −1 1 1 −1 −1 −1 −1 1 1 1 −1 −1 −1 1 −1 −1 −1 1 −1 1 −1 −1 |
| | −1 1 −1 −1 −1 −1 −1 1 −1 −1 −1 1 1 −1 1 1 1 −1 1 1 1 1 −1 1 1 1 −1 1 1 −1 −1 |
| | −1 1 −1 −1 −1 1 1 −1 1 1 1 −1 1 −1 1 1 1 −1 1 1 1 −1 −1 −1 1 −1 −1 −1 1 −1 1 |
| | −1 −1 −1 1 −1 −1 −1 −1 −1 1 −1 −1 −1 1 1 −1 1 1 1 −1 1 1 −1 −1 1 −1 −1 −1 1 |
| | −1 −1 1 1 1 −1 1 1 1 −1 −1 1 −1 −1 −1 1 −1 1 −1 −1 −1 1 −1 −1 −1 −1 −1 −1 1 1 |
| | 1 1 −1 −1 1 −1 −1 1 −1 1 1 −1 −1 −1 1 1 1 1 −1 1 −1 1 1 −1 1 −1 −1 1 1 −1 1 −1 |
| | −1 1 −1 1 −1 −1 −1 −1 1 1 1 1 1 −1 1 −1 −1 1 −1 −1 1 1 1 1 −1 −1 −1 1 1 1 −1 |
| | −1 −1 −1 1 1 −1 1 1 −1 1 −1 1 1 1 −1 −1 −1 −1 1 −1 1 −1 −1 1 −1 1 1 1 1 −1 |
| | 1 −1 −1 1 −1 1 −1 −1 −1 −1 1 1 1 1 1 −1 1 −1 −1 1 −1 −1 1 1 1 1 −1 −1 −1 1 1 1 |
| | −1 1 1 1 −1 1 −1 1 1 1 −1 1 1 1 1 1 −1 1 1 1 −1 −1 1 −1 −1 −1 1 −1 −1 −1 −1 1 |
| | −1 −1 −1 1 −1 −1 1 1 1 −1 1 1 1 −1 −1 1 −1 −1 −1 1 −1 1 −1 −1 −1 1 −1 −1 −1 |
| | −1 −1 −1 1 −1 −1 −1 1 −1 1 −1 −1 −1 1 −1 −1 −1 −1 −1 1 −1 −1 −1 1 1 −1 1 1 1 |
| | −1 1 1 −1 −1 1 −1 −1 −1 1 −1 −1 1 1 1 −1 1 1 1 −1 −1 1 −1 −1 −1 1 −1 1 −1 −1 |
| | −1 1 −1 −1 −1 −1 −1 −1 1 1 1 1 −1 −1 1 −1 −1 1 −1 1 1 −1 −1 −1 1 1 1 1 −1 1 −1 |
| | 1 1 −1 1 −1 −1 1 1 −1 1 −1 −1 1 −1 1 −1 −1 −1 −1 1 1 1 1 1 −1 1 −1 −1 1 −1 −1 |
| | 1 1 1 1 −1 −1 −1 −1 −1 −1 1 1 1 1 −1 −1 1 −1 −1 1 −1 1 1 −1 −1 −1 1 1 1 1 −1 1 |
| | −1 1 1 −1 1 −1 −1 −1 −1 1 −1 1 1 −1 1 −1 1 1 1 1 −1 −1 −1 −1 −1 1 −1 1 1 −1 1 |
| | 1 −1 −1 −1 −1 1 1 1 −1 −1 −1 1 −1 −1 −1 1 −1 1 −1 −1 −1 1 −1 −1 −1 −1 −1 1 |
| | −1 −1 −1 1 1 −1 1 1 1 −1 1 1 1 1 −1 1 1 1 −1 1 1 −1 −1 −1 1 −1 −1 −1 1 1 −1 1 1 |
| | 1 −1 1 −1 1 1 1 1 1 1 1 1 1 −1 1 1 1 −1 1 −1 1 1 1 −1 1 1 1 1 1 −1 1 1 1 −1 −1 |
| | 1 −1 −1 −1 1 −1 −1 1 1 −1 1 1 1 −1 1 1 −1 −1 −1 1 −1 −1 −1 1 1 −1 1 1 1 −1 1 |
| | −1 1 1 1 −1 1 1 1 1 1 1 −1 −1 −1 −1 1 1 −1 1 1 −1 1 −1 −1 1 1 1 −1 −1 −1 −1 1 |
| | −1 1 −1 −1 1 −1 1 1 −1 −1 1 −1 1 1 −1 1 −1 1 1 1 1 −1 −1 −1 −1 −1 1 −1 1 1 −1 |
| | 1 1 −1 −1 −1 −1 1 1 1 1 1 1 −1 −1 −1 −1 1 1 −1 1 1 −1 1 −1 −1 1 1 1 −1 −1 −1 |
| | −1 1 −1 1 −1 −1 1 −1 1 1 1 1 −1 1 −1 −1 1 −1 1 −1 −1 −1 −1 1 1 1 1 1 −1 1 −1 |
| | −1 1 −1 −1 1 1 1 1 −1 −1 −1 1 1 1 −1 1 1 1 −1 1 −1 1 1 1 −1 1 1 1 1 1 −1 1 1 1 |
| | −1 −1 1 −1 −1 −1 1 −1 −1 −1 −1 1 −1 −1 −1 1 −1 −1 1 1 1 −1 1 1 1 −1 −1 1 −1 |
| | −1 −1 1 −1 1 −1 −1 −1 1 −1 −1 −1 −1 −1 −1 1 −1 −1 −1 1 −1 1 −1 −1 −1 1 −1 −1 |
| | −1 −1 −1 1 −1 −1 −1 1 1 −1 1 1 1 −1 1 1 −1 −1 1 −1 −1 −1 1 −1 −1 1 1 1 −1 1 1 |
| | 1 −1 −1 1 −1 −1 −1 1 −1 1 −1 −1 −1 1 −1 −1 −1 −1 −1 −1 1 1 1 1 −1 −1 1 −1 −1 |
| | 1 −1 1 1 −1 −1 −1 1 1 1 1 −1 1 −1 1 1 −1 1 −1 −1 1 1 −1 1 −1 −1 1 −1 1 −1 −1 |
| | −1 −1 1 1 1 1 1 −1 1 −1 −1 1 −1 −1 1 1 1 1 −1 −1 −1 1 1 1 −1 −1 −1 −1 1 1 −1 1 |
| | 1 −1 1 −1 −1 1 1 1 −1 −1 −1 −1 1 −1 1 −1 −1 1 −1 1 1 1 1 −1 1 −1 −1 1 −1 1 −1 |
| | −1 −1 −1 1 1 1 1 1 −1 1 −1 −1 1 −1 −1 1 1 1 1 −1 −1 −1 1 1 1 −1 1 1 1 −1 1 −1 1 |
| | 1 1 −1 1 1 1 1 1 −1 1 1 1 −1 −1 1 −1 −1 −1 1 −1 −1 −1 −1 1 −1 −1 −1 1 −1 −1 1 |
| | 1 1 −1 1 1 1 −1 −1 1 −1 −1 −1 1 −1 1 −1 −1 −1 1 −1 −1 −1 −1 −1 −1 1 −1 −1 −1 |
| | 1 −1 1 −1 −1 −1 1 −1 −1 −1 −1 −1 1 −1 −1 −1 1 1 −1 1 1 1 −1 1 1 −1 −1 1 −1 −1 |
| | −1 1 −1 −1 1 1 1 −1 1 1 1 −1 −1 1 −1 −1 −1 1 −1 1 −1 −1 −1 1 −1 −1 −1 −1 −1 |
| | −1 1 1 1 1 −1 −1 1 −1 −1 1 −1 1 1 −1 −1 −1 1 1 1 1 −1 1 −1 1 1 −1 1 −1 −1 1 1 |
| | −1 1 −1 −1 1 −1 1 −1 −1 −1 −1 1 1 1 1 1 −1 1 −1 −1 1 −1 −1 1 1 1 1 −1 −1 −1 1 |
| | 1 1 −1 −1 −1 −1 1 1 −1 1 1 −1 1 −1 −1 1 1 1 −1 −1 −1 −1 1 −1 1 −1 −1 1 −1 1 1 |
| | 1 1 −1 1 −1 −1 1 −1 1 −1 −1 −1 −1 1 1 1 1 1 −1 1 −1 −1 1 −1 −1 1 1 1 1 −1 −1 |
| | −1 1 1 1 −1 1 1 1 −1 1 −1 1 1 1 −1 1 1 1 1 1 −1 1 1 1 −1 −1 1 −1 −1 −1 1 −1 −1 |
| | −1 −1 1 −1 −1 −1 1 −1 −1 1 1 1 −1 1 1 1 −1 −1 1 −1 −1 −1 1 −1 1 −1 −1 −1 1 −1 |
| | −1 −1 |
| 3 | 1 1 1 1 1 1 −1 −1 1 1 1 1 1 1 −1 −1 1 −1 1 −1 1 −1 −1 1 1 −1 1 −1 1 −1 −1 1 1 1 |
| | −1 −1 1 1 1 1 1 1 −1 −1 1 1 1 1 −1 1 1 −1 −1 1 −1 1 −1 1 1 −1 −1 1 −1 1 1 1 1 1 |
| | 1 1 −1 −1 1 1 1 1 1 1 −1 −1 1 −1 1 −1 1 −1 −1 1 1 −1 1 −1 1 −1 −1 1 1 1 −1 −1 1 |
| | 1 1 1 1 1 −1 −1 1 1 1 −1 1 1 −1 −1 1 −1 1 −1 1 1 −1 −1 1 −1 1 1 −1 1 −1 1 −1 |
| | −1 1 −1 1 −1 1 −1 1 1 −1 1 1 1 1 1 1 −1 −1 −1 −1 −1 −1 −1 −1 1 1 1 −1 −1 1 1 |
| | −1 1 −1 −1 1 1 −1 −1 1 −1 1 −1 −1 1 1 −1 −1 −1 −1 1 1 −1 −1 1 1 1 1 1 −1 1 −1 |
| | 1 −1 −1 1 −1 1 −1 1 −1 1 1 −1 1 1 1 1 1 1 −1 −1 −1 −1 −1 −1 −1 −1 1 1 1 −1 −1 |
| | 1 1 −1 1 −1 −1 1 1 −1 −1 1 −1 1 −1 −1 1 1 −1 −1 −1 −1 1 1 −1 −1 1 1 1 1 1 1 1 1 |
| | −1 −1 1 1 1 1 1 1 −1 −1 1 1 1 −1 1 −1 −1 1 1 −1 1 −1 1 −1 −1 1 1 −1 1 1 −1 −1 |
| | −1 −1 −1 −1 1 1 −1 −1 −1 −1 −1 −1 −1 1 1 −1 1 −1 1 −1 −1 1 1 −1 1 −1 1 −1 1 1 |
| | 1 1 −1 −1 1 1 1 1 1 1 −1 −1 1 1 1 −1 1 −1 −1 1 1 −1 1 −1 1 −1 −1 1 1 −1 1 1 −1 |
| | −1 −1 −1 −1 −1 1 1 −1 −1 −1 −1 −1 −1 −1 1 1 −1 1 −1 1 −1 −1 1 1 −1 1 −1 1 −1 |
| | 1 −1 1 −1 −1 1 1 −1 −1 1 −1 1 1 −1 −1 1 1 1 1 1 −1 −1 1 1 −1 −1 −1 −1 1 1 −1 |
| | −1 1 −1 −1 1 −1 1 −1 1 −1 1 1 −1 1 −1 1 −1 −1 −1 1 1 1 1 1 1 1 1 −1 −1 −1 −1 |
| | −1 −1 1 −1 1 −1 −1 1 1 −1 −1 1 −1 1 1 −1 −1 1 1 1 1 1 −1 −1 1 1 −1 −1 −1 −1 1 |
| | 1 −1 −1 1 −1 −1 1 −1 1 −1 1 −1 1 1 −1 1 −1 1 −1 −1 −1 1 1 1 1 1 1 1 1 −1 −1 −1 |
| | −1 −1 −1 1 1 1 1 1 1 −1 −1 −1 −1 −1 −1 −1 −1 1 1 1 −1 1 −1 1 −1 −1 1 −1 1 −1 1 |
| | −1 1 1 −1 1 1 −1 −1 1 1 1 1 −1 −1 1 1 −1 −1 −1 −1 −1 1 1 −1 −1 1 −1 1 1 −1 −1 |
| | 1 1 −1 1 −1 −1 −1 −1 −1 −1 −1 1 1 1 1 1 1 1 1 −1 −1 −1 1 −1 1 −1 1 1 −1 1 −1 1 |
| | −1 1 −1 −1 1 −1 −1 1 1 −1 −1 −1 −1 1 1 −1 −1 1 1 1 1 1 −1 −1 1 1 −1 1 −1 −1 1 |
| | 1 −1 −1 1 −1 1 1 −1 1 −1 1 −1 −1 1 1 1 1 −1 1 −1 −1 1 1 1 1 1 1 −1 −1 1 1 1 1 |
| | 1 1 −1 −1 1 −1 −1 1 1 −1 1 −1 1 −1 −1 1 1 −1 1 −1 −1 −1 1 1 −1 −1 −1 −1 −1 −1 |
| | 1 1 −1 −1 −1 −1 −1 1 −1 1 −1 1 1 −1 −1 1 −1 1 −1 1 1 −1 −1 −1 −1 −1 −1 −1 1 1 |
| | −1 −1 −1 −1 −1 −1 1 1 −1 1 1 −1 −1 1 −1 1 −1 1 1 −1 −1 1 −1 1 1 1 −1 −1 1 1 1 |
| | 1 1 1 −1 −1 1 1 1 1 1 1 1 1 −1 −1 1 1 −1 −1 −1 −1 1 1 −1 −1 1 −1 1 −1 −1 1 1 −1 |
| | −1 1 −1 1 1 −1 −1 1 1 1 −1 −1 −1 −1 −1 −1 −1 −1 1 1 1 1 1 1 −1 1 1 −1 1 −1 1 |
| | −1 1 −1 −1 1 −1 1 −1 1 −1 −1 −1 −1 1 1 −1 −1 1 1 1 1 −1 −1 1 1 −1 1 −1 1 1 −1 |
| | −1 1 1 −1 1 −1 −1 1 1 −1 −1 −1 1 1 1 1 1 1 1 −1 −1 −1 −1 −1 −1 1 −1 −1 1 −1 |
| | 1 −1 1 −1 1 1 −1 1 −1 1 −1 1 −1 1 −1 −1 1 1 −1 1 −1 1 −1 −1 1 1 −1 1 1 1 1 −1 |
| | −1 1 1 1 1 1 1 −1 −1 1 1 1 −1 −1 1 −1 1 −1 1 1 −1 −1 1 −1 1 −1 1 −1 −1 1 1 1 1 1 |
| | 1 −1 −1 1 1 1 1 1 1 −1 1 −1 1 1 −1 −1 1 −1 1 −1 1 1 −1 −1 1 −1 −1 −1 −1 1 1 −1 |
| | −1 −1 −1 −1 −1 1 1 −1 −1 −1 1 1 −1 1 −1 1 −1 −1 1 1 −1 1 −1 1 −1 1 1 −1 −1 −1 |
| | −1 −1 −1 1 1 −1 −1 −1 −1 −1 −1 1 1 1 1 1 1 −1 −1 1 1 1 1 1 1 −1 −1 1 −1 1 −1 1 |
| | −1 −1 1 1 −1 1 −1 1 −1 −1 1 1 1 −1 −1 1 1 1 1 1 1 −1 −1 1 1 1 1 −1 1 1 −1 −1 1 |
| | −1 1 −1 1 1 −1 −1 1 −1 1 −1 −1 −1 −1 −1 −1 1 1 −1 −1 −1 −1 −1 −1 1 1 −1 1 −1 |
| | 1 −1 1 1 −1 −1 1 −1 1 −1 1 1 −1 −1 −1 1 1 −1 −1 −1 −1 −1 −1 1 1 −1 −1 −1 −1 1 |
| | −1 −1 1 1 −1 1 −1 1 −1 −1 1 1 −1 1 −1 1 −1 1 −1 1 −1 −1 1 −1 1 −1 1 −1 1 1 −1 |
| | 1 1 1 1 1 1 −1 −1 −1 −1 −1 −1 −1 −1 1 1 1 −1 −1 1 1 −1 1 −1 −1 1 1 −1 −1 1 −1 |
| | 1 −1 −1 1 1 −1 −1 −1 −1 1 1 −1 −1 1 1 1 1 −1 1 −1 1 −1 1 1 −1 1 −1 1 −1 1 −1 |
| | −1 1 −1 −1 −1 −1 −1 −1 1 1 1 1 1 1 1 1 −1 −1 −1 1 1 −1 −1 1 −1 1 1 −1 −1 1 1 |
| | −1 1 −1 1 1 −1 −1 1 1 1 1 −1 −1 1 1 −1 −1 −1 −1 1 1 1 1 −1 −1 1 1 1 1 1 1 −1 −1 |
| | 1 1 1 −1 1 −1 −1 1 1 −1 1 −1 1 −1 −1 1 1 −1 1 1 −1 −1 −1 −1 −1 −1 1 1 −1 −1 −1 |
| | −1 −1 −1 −1 1 1 −1 1 −1 1 −1 −1 1 1 −1 1 −1 1 −1 −1 −1 −1 −1 1 1 −1 −1 −1 −1 |
| | −1 −1 1 1 −1 −1 −1 1 −1 1 1 −1 −1 1 −1 1 −1 1 1 −1 −1 1 −1 −1 1 1 1 1 1 1 −1 |
| | −1 1 1 1 1 1 1 1 −1 −1 1 −1 1 −1 1 1 −1 −1 1 −1 1 −1 1 1 −1 1 −1 −1 1 1 −1 −1 1 |
| | −1 1 1 −1 −1 1 1 1 1 1 −1 −1 1 1 −1 −1 −1 −1 1 1 −1 −1 1 −1 −1 1 −1 1 −1 1 −1 |
| | 1 1 −1 1 −1 1 −1 −1 −1 1 1 1 1 1 1 1 1 −1 −1 −1 −1 −1 −1 −1 1 −1 1 1 −1 −1 1 1 |
| | −1 1 −1 −1 1 1 −1 −1 −1 −1 −1 1 1 −1 −1 1 1 1 1 −1 −1 1 1 −1 1 1 −1 1 −1 1 −1 |
| | 1 −1 −1 1 −1 1 −1 1 1 1 −1 −1 −1 −1 −1 −1 −1 −1 1 1 1 1 1 1 1 1 1 1 1 1 −1 −1 |
| | −1 −1 −1 −1 −1 −1 1 1 1 −1 1 −1 1 −1 −1 1 −1 1 −1 1 −1 1 1 −1 1 1 −1 −1 1 1 1 |
| | 1 −1 −1 1 1 −1 −1 −1 −1 −1 1 1 −1 −1 1 −1 1 1 −1 −1 1 1 −1 1 −1 1 1 1 1 1 1 −1 |
| | −1 −1 −1 −1 −1 −1 −1 1 1 1 −1 1 −1 1 −1 −1 1 −1 1 −1 1 −1 1 1 −1 1 1 −1 −1 1 1 |
| | 1 1 −1 −1 1 1 −1 −1 −1 −1 −1 1 1 −1 −1 1 −1 1 1 −1 −1 1 1 −1 1 −1 1 −1 1 −1 1 |
| | −1 −1 1 1 −1 1 −1 1 −1 −1 1 1 1 1 1 1 1 −1 −1 1 1 1 1 1 1 −1 −1 1 −1 −1 1 1 −1 1 |
| | −1 1 −1 −1 1 1 −1 1 −1 −1 −1 1 1 −1 −1 −1 −1 −1 −1 1 1 −1 −1 −1 −1 1 −1 1 −1 |
| | 1 −1 −1 1 1 −1 1 −1 1 −1 −1 1 1 1 1 1 1 1 −1 −1 1 1 1 1 1 1 −1 −1 1 −1 −1 1 1 −1 |
| | 1 −1 1 −1 −1 1 1 −1 1 −1 −1 −1 1 1 −1 −1 −1 −1 −1 −1 1 1 −1 −1 −1 −1 1 1 1 1 |
| | −1 −1 1 1 −1 −1 −1 −1 1 1 −1 −1 1 −1 1 −1 −1 1 1 −1 −1 1 −1 1 1 −1 −1 1 1 1 −1 |
| | −1 −1 −1 −1 −1 −1 −1 1 1 1 1 1 1 −1 1 1 −1 1 −1 1 −1 1 −1 −1 1 −1 1 −1 1 1 1 1 |
| | 1 −1 −1 1 1 −1 −1 −1 −1 1 1 −1 −1 1 −1 1 −1 −1 1 1 −1 −1 1 −1 1 1 −1 −1 1 1 1 |
| | −1 −1 −1 −1 −1 −1 −1 −1 1 1 1 1 1 1 −1 1 1 −1 1 −1 1 −1 1 −1 −1 1 −1 1 −1 1 1 |
| | −1 1 −1 −1 1 1 −1 1 −1 1 −1 −1 1 1 −1 1 1 1 1 −1 −1 1 1 1 1 1 1 −1 −1 1 1 1 −1 |
| | −1 1 −1 1 −1 1 1 −1 −1 1 −1 1 −1 1 −1 −1 1 1 1 1 1 1 −1 −1 1 1 1 1 1 1 1 −1 1 −1 |
| | −1 1 1 −1 1 −1 1 −1 −1 1 1 −1 1 1 1 1 −1 −1 1 1 1 1 1 1 −1 −1 1 1 1 −1 −1 1 −1 1 |
| | −1 1 1 −1 −1 1 −1 1 −1 1 −1 −1 1 1 1 1 1 1 −1 −1 1 1 1 1 1 1 1 1 1 1 1 1 −1 −1 1 |
| | 1 1 1 1 1 −1 −1 1 −1 1 −1 1 −1 −1 1 1 −1 1 −1 1 −1 −1 1 1 1 −1 −1 1 1 1 1 1 1 −1 |
| | −1 1 1 1 1 −1 1 1 −1 −1 1 −1 1 −1 1 1 −1 −1 1 −1 1 1 1 1 1 1 1 −1 −1 1 1 1 1 1 1 |
| | −1 −1 1 −1 1 −1 1 −1 −1 1 1 −1 1 −1 1 −1 −1 1 1 1 −1 −1 1 1 1 1 1 1 −1 −1 1 1 1 |
| | 1 −1 1 1 −1 −1 1 −1 1 −1 1 1 −1 −1 1 −1 1 1 −1 1 −1 1 −1 −1 1 −1 1 −1 1 −1 1 1 |
| | −1 1 1 1 1 1 1 −1 −1 −1 −1 −1 −1 −1 −1 1 1 1 −1 −1 1 1 −1 1 −1 −1 1 1 −1 −1 1 |
| | −1 1 −1 −1 1 1 −1 −1 −1 −1 1 1 −1 −1 1 1 1 1 1 −1 1 −1 1 −1 −1 1 −1 1 −1 1 −1 |
| | 1 1 −1 1 1 1 1 1 1 −1 −1 −1 −1 −1 −1 −1 −1 1 1 1 −1 −1 1 1 −1 1 −1 −1 1 1 −1 |
| | −1 1 −1 1 −1 −1 1 1 −1 −1 −1 −1 1 1 −1 −1 1 1 1 1 1 1 1 1 −1 −1 1 1 1 1 1 1 −1 |
| | −1 1 1 1 −1 1 −1 −1 1 1 −1 1 −1 1 −1 −1 1 1 −1 1 1 −1 −1 −1 −1 −1 −1 1 1 −1 −1 |
| | −1 −1 −1 −1 −1 1 1 −1 1 −1 1 −1 −1 1 1 −1 1 −1 1 −1 1 1 1 1 −1 −1 1 1 1 1 1 1 |
| | −1 −1 1 1 1 −1 1 −1 −1 1 1 −1 1 −1 1 −1 −1 1 1 −1 1 1 −1 −1 −1 −1 −1 −1 1 1 −1 |
| | −1 −1 −1 −1 −1 −1 1 1 −1 1 −1 1 −1 −1 1 1 −1 1 −1 1 −1 1 −1 1 −1 −1 1 1 −1 −1 |
| | 1 −1 1 1 −1 −1 1 1 1 1 1 −1 −1 1 1 −1 −1 −1 −1 1 1 −1 −1 1 −1 −1 1 −1 1 −1 1 |
| | −1 1 1 −1 1 −1 1 −1 −1 −1 1 1 1 1 1 1 1 1 −1 −1 −1 −1 −1 −1 1 −1 1 −1 −1 1 1 |
| | −1 −1 1 −1 1 1 −1 −1 1 1 1 1 1 −1 −1 1 1 −1 −1 −1 −1 1 1 −1 −1 1 −1 −1 1 −1 1 |
| | −1 1 −1 1 1 −1 1 −1 1 −1 −1 −1 1 1 1 1 1 1 1 1 −1 −1 −1 −1 −1 −1 1 1 1 1 1 1 −1 |
| | −1 −1 −1 −1 −1 −1 −1 1 1 1 −1 1 −1 1 −1 −1 1 −1 1 −1 1 −1 1 1 −1 1 1 −1 −1 1 1 |
| | 1 1 −1 −1 1 1 −1 −1 −1 −1 −1 1 1 −1 −1 1 −1 1 1 −1 −1 1 1 −1 1 −1 −1 −1 −1 −1 |
| | −1 −1 1 1 1 1 1 1 1 1 −1 −1 −1 1 −1 1 −1 1 1 −1 1 −1 1 −1 1 −1 −1 1 −1 −1 1 1 |
| | −1 −1 −1 −1 1 1 −1 −1 1 1 1 1 1 −1 −1 1 1 −1 1 −1 −1 1 1 −1 −1 1 −1 1 1 −1 1 |
| | −1 1 −1 −1 1 1 −1 1 −1 1 −1 −1 1 1 1 1 1 1 1 −1 −1 1 1 1 1 1 1 −1 −1 1 −1 −1 1 1 |
| | −1 1 −1 1 −1 −1 1 1 −1 1 −1 −1 −1 1 1 −1 −1 −1 −1 −1 −1 1 1 −1 −1 −1 −1 −1 1 |
| | −1 1 −1 1 1 −1 −1 1 −1 1 −1 1 1 −1 −1 −1 −1 −1 −1 −1 1 1 −1 −1 −1 −1 −1 −1 1 |
| | 1 −1 1 1 −1 −1 1 −1 1 −1 1 1 −1 −1 1 −1 1 1 1 −1 −1 1 1 1 1 1 1 −1 −1 1 1 1 1 1 |
| | 1 1 1 −1 −1 1 1 −1 −1 −1 −1 1 1 −1 −1 1 −1 1 −1 −1 1 1 −1 −1 1 −1 1 1 −1 −1 1 |
| | 1 1 −1 −1 −1 −1 −1 −1 −1 −1 1 1 1 1 1 1 −1 1 1 −1 1 −1 1 −1 1 −1 −1 1 −1 1 −1 |
| | 1 −1 −1 −1 −1 1 1 −1 −1 1 1 1 1 −1 −1 1 1 −1 1 −1 1 1 −1 −1 1 1 −1 1 −1 −1 1 1 |
| | −1 −1 −1 1 1 1 1 1 1 1 1 −1 −1 −1 −1 −1 −1 1 −1 −1 1 −1 1 −1 1 −1 1 1 −1 1 −1 |
| | 1 −1 1 −1 1 −1 −1 1 1 −1 1 −1 1 −1 −1 1 1 −1 1 1 1 1 −1 −1 1 1 1 1 1 1 −1 −1 1 1 |
| | 1 −1 −1 1 −1 1 −1 1 1 −1 −1 1 −1 1 −1 1 −1 −1 1 1 1 1 1 1 −1 −1 1 1 1 1 1 −1 1 |
| | −1 1 1 −1 −1 1 −1 1 −1 1 1 −1 −1 1 −1 −1 −1 −1 1 1 −1 −1 −1 −1 −1 −1 1 1 −1 |
| | −1 −1 1 1 −1 1 −1 1 −1 −1 1 1 −1 1 −1 1 −1 1 1 −1 −1 −1 −1 −1 −1 1 1 −1 −1 −1 |
| | −1 −1 −1 −1 −1 −1 −1 −1 −1 1 1 −1 −1 −1 −1 −1 −1 1 1 −1 1 −1 1 −1 1 1 −1 −1 |
| | 1 −1 1 −1 1 1 −1 −1 −1 1 1 −1 −1 −1 −1 −1 −1 1 1 −1 −1 −1 −1 1 −1 −1 1 1 −1 1 |
| | −1 1 −1 −1 1 1 −1 1 −1 1 1 1 1 1 1 −1 −1 1 1 1 1 1 1 −1 −1 1 −1 1 −1 1 −1 −1 1 1 |
| | −1 1 −1 1 −1 −1 1 1 1 −1 −1 1 1 1 1 1 1 −1 −1 1 1 1 1 −1 1 1 −1 −1 1 −1 1 −1 1 1 |
| | −1 −1 1 −1 1 −1 1 −1 1 −1 1 1 −1 1 −1 1 −1 1 −1 −1 1 −1 −1 −1 −1 −1 −1 1 1 1 1 |
| | 1 1 1 1 −1 −1 −1 1 1 −1 −1 1 −1 1 1 −1 −1 1 1 −1 1 −1 1 1 −1 −1 1 1 1 1 −1 −1 1 |
| | 1 −1 −1 −1 −1 1 −1 1 −1 1 −1 −1 1 −1 1 −1 1 −1 1 1 −1 1 1 1 1 1 1 −1 −1 −1 −1 |
| | −1 −1 −1 −1 1 1 1 −1 −1 1 1 −1 1 −1 −1 1 1 −1 −1 1 −1 1 −1 −1 1 1 −1 −1 −1 −1 |
| | 1 1 −1 −1 1 1 1 1 −1 −1 −1 −1 1 1 −1 −1 −1 −1 −1 −1 1 1 −1 −1 −1 1 −1 1 1 −1 |
| | −1 1 −1 1 −1 1 1 −1 −1 1 −1 −1 1 1 1 1 1 1 −1 −1 1 1 1 1 1 1 1 −1 −1 1 −1 1 −1 1 |
| | 1 −1 −1 1 −1 1 −1 1 1 1 1 1 −1 −1 1 1 1 1 1 1 −1 −1 1 1 1 −1 1 −1 −1 1 1 −1 1 −1 |
| | 1 −1 −1 1 1 −1 1 1 −1 −1 −1 −1 −1 −1 1 1 −1 −1 −1 −1 −1 −1 −1 1 1 −1 1 −1 1 |
| | −1 −1 1 1 −1 1 −1 1 −1 −1 1 −1 1 1 −1 −1 1 1 −1 1 −1 −1 1 1 −1 −1 −1 −1 −1 1 1 |
| | −1 −1 1 1 1 1 −1 −1 1 1 −1 1 1 −1 1 −1 1 −1 1 −1 −1 1 −1 1 −1 1 1 1 −1 −1 −1 |
| | −1 −1 −1 −1 −1 1 1 1 1 1 1 1 −1 1 −1 −1 1 1 −1 −1 1 −1 1 1 −1 −1 1 1 1 1 1 −1 |
| | −1 1 1 −1 −1 −1 −1 1 1 −1 −1 1 −1 −1 1 −1 1 −1 1 −1 1 1 −1 1 −1 1 −1 −1 −1 1 1 |
| | 1 1 1 1 1 1 −1 −1 −1 −1 −1 −1 −1 −1 −1 −1 −1 −1 1 1 1 1 1 1 1 1 −1 −1 −1 1 −1 |
| | 1 −1 1 1 −1 1 −1 1 −1 1 −1 −1 1 −1 −1 1 1 −1 −1 −1 −1 1 1 −1 −1 1 1 1 1 1 −1 |
| | −1 1 1 −1 1 −1 −1 1 1 −1 −1 1 −1 1 −1 −1 −1 −1 −1 −1 1 1 1 1 1 1 1 1 −1 −1 −1 |
| | 1 −1 1 −1 1 1 −1 1 −1 1 −1 1 −1 −1 1 −1 −1 1 1 −1 −1 −1 −1 1 1 −1 −1 1 1 1 1 1 |
| | −1 −1 1 1 −1 1 −1 −1 1 1 −1 −1 1 −1 1 −1 1 −1 1 −1 1 1 −1 −1 1 −1 1 −1 1 1 −1 |
| | −1 −1 −1 −1 −1 −1 1 1 −1 −1 −1 −1 −1 −1 1 1 −1 1 1 −1 −1 1 −1 1 −1 1 1 −1 −1 |
| | 1 −1 1 1 1 −1 −1 1 1 1 1 1 1 −1 −1 1 1 1 1 −1 1 −1 1 −1 1 1 −1 −1 1 −1 1 −1 1 1 |
| | −1 −1 −1 −1 −1 −1 −1 1 1 −1 −1 −1 −1 −1 −1 1 1 −1 1 1 −1 −1 1 −1 1 −1 1 1 −1 |
| | −1 1 −1 1 1 1 −1 −1 1 1 1 1 1 1 −1 −1 1 1 1 1 −1 −1 −1 −1 1 1 −1 −1 1 1 1 1 −1 |
| | −1 1 1 −1 1 −1 1 1 −1 −1 1 1 −1 1 −1 −1 1 1 −1 −1 −1 1 1 1 1 1 1 1 1 −1 −1 −1 |
| | −1 −1 −1 1 −1 −1 1 −1 1 −1 1 −1 1 1 −1 1 −1 1 −1 −1 −1 −1 −1 1 1 −1 −1 1 1 1 1 |
| | −1 −1 1 1 −1 1 −1 1 1 −1 −1 1 1 −1 1 −1 −1 1 1 −1 −1 −1 1 1 1 1 1 1 1 1 −1 −1 |
| | −1 −1 −1 −1 1 −1 −1 1 −1 1 −1 1 −1 1 1 −1 1 −1 1 −1 −1 1 −1 1 1 −1 −1 1 −1 1 |
| | −1 1 1 −1 −1 1 −1 −1 −1 −1 1 1 −1 −1 −1 −1 −1 −1 1 1 −1 −1 −1 1 1 −1 1 −1 1 |
| | −1 −1 1 1 −1 1 −1 1 −1 1 1 −1 −1 −1 −1 −1 −1 1 1 −1 −1 −1 −1 −1 −1 −1 1 −1 1 |
| | 1 −1 −1 1 −1 1 −1 1 1 −1 −1 1 −1 −1 −1 −1 1 1 −1 −1 −1 −1 −1 −1 1 1 −1 −1 −1 |
| | 1 1 −1 1 −1 1 −1 −1 1 1 −1 1 −1 1 −1 1 1 −1 −1 −1 −1 −1 −1 1 1 −1 −1 −1 −1 −1 |
| | −1 −1 −1 −1 −1 −1 −1 1 1 −1 −1 −1 −1 −1 −1 1 1 −1 1 −1 1 −1 1 1 −1 −1 1 −1 1 |
| | −1 1 1 −1 −1 −1 1 1 −1 −1 −1 −1 −1 −1 1 1 −1 −1 −1 −1 1 −1 −1 1 1 −1 1 −1 1 |
| | −1 −1 1 1 −1 1 −1 −1 −1 −1 −1 −1 −1 1 1 −1 −1 −1 −1 −1 −1 1 1 −1 1 −1 1 −1 1 |
| | 1 −1 −1 1 −1 1 −1 1 1 −1 −1 −1 1 1 −1 −1 −1 −1 −1 −1 1 1 −1 −1 −1 −1 1 −1 −1 |
| | 1 1 −1 1 −1 1 −1 −1 1 1 −1 1 −1 −1 1 −1 1 −1 1 1 −1 1 −1 1 −1 1 −1 −1 1 −1 −1 |
| | −1 −1 −1 −1 1 1 1 1 1 1 1 1 −1 −1 −1 1 1 −1 −1 1 −1 1 1 −1 −1 1 1 −1 1 −1 1 1 |
| | −1 −1 1 1 1 1 −1 −1 1 1 −1 −1 −1 −1 −1 1 −1 1 −1 1 1 −1 1 −1 1 −1 1 −1 −1 1 −1 |
| | −1 −1 −1 −1 −1 1 1 1 1 1 1 1 1 −1 −1 −1 1 1 −1 −1 1 −1 1 1 −1 −1 1 1 −1 1 −1 1 |
| | 1 −1 −1 1 1 1 1 −1 −1 1 1 −1 −1 −1 −1 −1 −1 −1 −1 1 1 −1 −1 −1 −1 −1 −1 1 1 |
| | −1 −1 −1 1 −1 1 1 −1 −1 1 −1 1 −1 1 1 −1 −1 1 −1 −1 1 1 1 1 1 1 −1 −1 1 1 1 1 1 |
| | 1 1 −1 −1 1 −1 1 −1 1 1 −1 −1 1 −1 1 −1 1 −1 −1 −1 −1 1 1 −1 −1 −1 −1 −1 −1 1 |
| | 1 −1 −1 −1 1 −1 1 1 −1 −1 1 −1 1 −1 1 1 −1 −1 1 −1 −1 1 1 1 1 1 1 −1 −1 1 1 1 1 |
| | 1 1 1 −1 −1 1 −1 1 −1 1 1 −1 −1 1 −1 1 −1 1 −1 1 −1 1 1 −1 −1 1 1 −1 1 −1 −1 1 |
| | 1 −1 −1 −1 −1 −1 1 1 −1 −1 1 1 1 1 −1 −1 1 1 −1 1 1 −1 1 −1 1 −1 1 −1 −1 1 −1 |
| | 1 −1 1 1 1 −1 −1 −1 −1 −1 −1 −1 −1 1 1 1 1 1 1 −1 1 −1 1 1 −1 −1 1 1 −1 1 −1 |
| | −1 1 1 −1 −1 −1 −1 −1 1 1 −1 −1 1 1 1 1 −1 −1 1 1 −1 1 1 −1 1 −1 1 −1 1 −1 −1 |
| | 1 −1 1 −1 1 1 1 −1 −1 −1 −1 −1 −1 −1 −1 1 1 1 1 1 1 −1 −1 −1 −1 −1 −1 1 1 1 1 |
| | 1 1 1 1 −1 −1 −1 1 −1 1 −1 1 1 −1 1 −1 1 −1 1 −1 −1 1 −1 −1 1 1 −1 −1 −1 −1 1 |
| | 1 −1 −1 1 1 1 1 1 −1 −1 1 1 −1 1 −1 −1 1 1 −1 −1 1 −1 1 1 1 1 1 1 1 −1 −1 −1 −1 |
| | −1 −1 −1 −1 1 1 1 −1 1 −1 1 −1 −1 1 −1 1 −1 1 −1 1 1 −1 1 1 −1 −1 1 1 1 1 −1 |
| | −1 1 1 −1 −1 −1 −1 −1 1 1 −1 −1 1 −1 1 1 −1 −1 1 1 −1 1 −1 −1 1 −1 1 −1 1 1 −1 |
| | −1 1 −1 1 −1 1 1 −1 −1 −1 −1 −1 −1 −1 1 1 −1 −1 −1 −1 −1 −1 1 1 −1 1 1 −1 −1 |
| | 1 −1 1 −1 1 1 −1 −1 1 −1 1 1 1 −1 −1 1 1 1 1 1 1 −1 −1 1 1 1 1 1 −1 1 −1 1 −1 −1 |
| | 1 1 −1 1 −1 1 −1 −1 1 1 1 1 1 1 1 −1 −1 1 1 1 1 1 1 −1 −1 1 −1 −1 1 1 −1 1 −1 1 |
| | −1 −1 1 1 −1 1 −1 −1 −1 1 1 −1 −1 −1 −1 −1 −1 1 1 −1 −1 −1 −1 −1 −1 −1 −1 1 |
| | 1 −1 −1 1 1 1 1 −1 −1 1 1 −1 1 −1 1 1 −1 −1 1 1 −1 1 −1 −1 1 1 −1 −1 −1 1 1 1 1 |
| | 1 1 1 1 −1 −1 −1 −1 −1 −1 1 −1 −1 1 −1 1 −1 1 −1 1 1 −1 1 −1 1 −1 1 1 1 1 −1 |
| | −1 1 1 −1 −1 −1 −1 1 1 −1 −1 1 −1 1 −1 −1 1 1 −1 −1 1 −1 1 1 −1 −1 1 1 1 −1 −1 |
| | −1 −1 −1 −1 −1 −1 1 1 1 1 1 1 −1 1 1 −1 1 −1 1 −1 1 −1 −1 1 −1 1 −1 1 −1 1 −1 |
| | 1 1 −1 −1 1 −1 1 −1 1 1 −1 −1 1 −1 −1 −1 −1 1 1 −1 −1 −1 −1 −1 −1 1 1 −1 −1 |
| | −1 1 1 −1 1 −1 1 −1 −1 1 1 −1 1 −1 1 −1 1 1 −1 −1 −1 −1 −1 −1 1 1 −1 −1 −1 −1 |
| | −1 −1 1 −1 1 −1 −1 1 1 −1 1 −1 1 −1 −1 1 1 −1 1 1 1 1 −1 −1 1 1 1 1 1 1 −1 −1 1 |
| | 1 1 −1 −1 1 −1 1 −1 1 1 −1 −1 1 −1 1 −1 1 −1 −1 1 1 1 1 1 1 −1 −1 1 1 1 1 1 1 −1 |
| | −1 −1 −1 −1 −1 1 1 −1 −1 −1 −1 −1 −1 1 1 −1 1 −1 1 −1 1 1 −1 −1 1 −1 1 −1 1 1 |
| | −1 −1 −1 1 1 −1 −1 −1 −1 −1 −1 1 1 −1 −1 −1 −1 1 −1 −1 1 1 −1 1 −1 1 −1 −1 1 |
| | 1 −1 1 −1 1 1 1 1 1 1 −1 −1 1 1 1 1 1 1 −1 −1 1 −1 1 −1 1 −1 −1 1 1 −1 1 −1 1 −1 |
| | −1 1 1 1 −1 −1 1 1 1 1 1 1 −1 −1 1 1 1 1 −1 1 1 −1 −1 1 −1 1 −1 1 1 −1 −1 1 −1 1 |
| | −1 1 −1 1 −1 1 1 −1 1 −1 1 −1 1 −1 −1 1 −1 −1 −1 −1 −1 −1 1 1 1 1 1 1 1 1 −1 |
| | −1 −1 1 1 −1 −1 1 −1 1 1 −1 −1 1 1 −1 1 −1 1 1 −1 −1 1 1 1 1 −1 −1 1 1 −1 −1 |
| | −1 −1 1 −1 1 −1 1 −1 −1 1 −1 1 −1 1 −1 1 1 −1 1 1 1 1 1 1 −1 −1 −1 −1 −1 −1 −1 |
| | −1 1 1 1 −1 −1 1 1 −1 1 −1 −1 1 1 −1 −1 1 −1 1 −1 −1 1 1 −1 −1 −1 −1 1 1 −1 −1 |
| | 1 1 1 1 −1 −1 −1 −1 1 1 −1 −1 −1 −1 −1 −1 1 1 −1 −1 −1 1 −1 1 1 −1 −1 1 −1 1 |
| | −1 1 1 −1 −1 1 −1 −1 1 1 1 1 1 1 −1 −1 1 1 1 1 1 1 1 −1 −1 1 −1 1 −1 1 1 −1 −1 1 |
| | −1 1 −1 1 1 1 1 1 −1 −1 1 1 1 1 1 1 −1 −1 1 1 1 −1 1 −1 −1 1 1 −1 1 −1 1 −1 −1 1 |
| | 1 −1 1 1 −1 −1 −1 −1 −1 −1 1 1 −1 −1 −1 −1 −1 −1 −1 1 1 −1 1 −1 1 −1 −1 1 1 |
| | −1 1 −1 1 −1 −1 1 −1 1 1 −1 −1 1 1 −1 1 −1 −1 1 1 −1 −1 −1 −1 −1 1 1 −1 −1 1 1 |
| | 1 1 −1 −1 1 1 −1 1 1 −1 1 −1 1 −1 1 −1 −1 1 −1 1 −1 1 1 1 −1 −1 −1 −1 −1 −1 −1 |
| | −1 1 1 1 1 1 1 1 −1 1 −1 −1 1 1 −1 −1 1 −1 1 1 −1 −1 1 1 1 1 1 −1 −1 1 1 −1 −1 |
| | −1 −1 1 1 −1 −1 1 −1 −1 1 −1 1 −1 1 −1 1 1 −1 1 −1 1 −1 −1 −1 1 1 1 1 1 1 1 1 |
| | −1 −1 −1 −1 −1 −1 −1 −1 −1 −1 −1 −1 1 1 1 1 1 −1 −1 −1 1 −1 1 −1 1 1 −1 |
| | 1 −1 1 −1 1 −1 −1 1 −1 −1 1 1 −1 −1 −1 −1 1 1 −1 −1 1 1 1 1 1 −1 −1 1 1 −1 1 |
| | −1 −1 1 1 −1 −1 1 −1 1 −1 −1 −1 −1 −1 −1 1 1 1 1 1 1 1 1 −1 −1 −1 1 −1 1 −1 1 |
| | 1 −1 1 −1 1 −1 1 −1 −1 1 −1 −1 1 1 −1 −1 −1 −1 1 1 −1 −1 1 1 1 1 1 −1 −1 1 1 |
| | −1 1 −1 −1 1 1 −1 −1 1 −1 1 −1 1 −1 1 −1 1 1 −1 −1 1 −1 1 −1 1 1 −1 −1 −1 −1 |
| | −1 −1 −1 1 1 −1 −1 −1 −1 −1 −1 1 1 −1 1 1 −1 −1 1 −1 1 −1 1 1 −1 −1 1 −1 1 1 1 |
| | −1 −1 1 1 1 1 1 1 −1 −1 1 1 1 1 −1 1 −1 1 −1 1 1 −1 −1 1 −1 1 −1 1 1 −1 −1 −1 |
| | −1 −1 −1 −1 1 1 −1 −1 −1 −1 −1 −1 1 1 −1 1 1 −1 −1 1 −1 1 −1 1 1 −1 −1 1 −1 1 |
| | 1 1 −1 −1 1 1 1 1 1 1 −1 −1 1 1 1 1 −1 −1 −1 −1 1 1 −1 −1 1 1 1 1 −1 −1 1 1 −1 1 |
| | −1 1 1 −1 −1 1 1 −1 1 −1 −1 1 1 −1 −1 −1 1 1 1 1 1 1 1 1 −1 −1 −1 −1 −1 −1 1 |
| | −1 −1 1 −1 1 −1 1 −1 1 1 −1 1 −1 1 −1 −1 −1 −1 −1 1 1 −1 −1 1 1 1 1 −1 −1 1 1 |
| | −1 1 −1 1 1 −1 −1 1 1 −1 1 −1 −1 1 1 −1 −1 −1 1 1 1 1 1 1 1 1 −1 −1 −1 −1 −1 |
| | −1 1 −1 −1 1 −1 1 −1 1 −1 1 1 −1 1 −1 1 −1 −1 1 −1 1 1 −1 −1 1 −1 1 −1 1 1 −1 |
| | −1 1 −1 −1 −1 −1 1 1 −1 −1 −1 −1 −1 −1 1 1 −1 −1 −1 1 1 −1 1 −1 1 −1 −1 1 1 |
| | −1 1 −1 1 −1 1 1 −1 −1 −1 −1 −1 −1 1 1 −1 −1 −1 −1 −1 −1 −1 1 −1 1 1 −1 −1 1 |
| | −1 1 −1 1 1 −1 −1 1 −1 −1 −1 −1 1 1 −1 −1 −1 −1 −1 −1 1 1 −1 −1 −1 1 1 −1 1 |
| | −1 1 −1 −1 1 1 −1 1 −1 1 −1 1 1 −1 −1 −1 −1 −1 −1 1 1 −1 −1 −1 −1 −1 −1 1 1 1 |
| | 1 1 1 −1 −1 1 1 1 1 1 1 −1 −1 1 −1 1 −1 1 −1 −1 1 1 −1 1 −1 1 −1 −1 1 1 1 −1 −1 |
| | 1 1 1 1 1 1 −1 −1 1 1 1 1 −1 1 1 −1 −1 1 −1 1 −1 1 1 −1 −1 1 −1 1 1 1 1 1 1 1 −1 |
| | −1 1 1 1 1 1 1 −1 −1 1 −1 1 −1 1 −1 −1 1 1 −1 1 −1 1 −1 −1 1 1 1 −1 −1 1 1 1 1 1 |
| | 1 −1 −1 1 1 1 1 −1 1 1 −1 −1 1 −1 1 −1 1 1 −1 −1 1 −1 1 1 −1 1 −1 1 −1 −1 1 −1 |
| | 1 −1 1 −1 1 1 −1 1 1 1 1 1 1 −1 −1 −1 −1 −1 −1 −1 −1 1 1 1 −1 −1 1 1 −1 1 −1 |
| | −1 1 1 −1 −1 1 −1 1 −1 −1 1 1 −1 −1 −1 −1 1 1 −1 −1 1 1 1 1 −1 1 −1 1 −1 −1 |
| | 1 −1 1 −1 1 −1 1 1 −1 1 1 1 1 1 1 −1 −1 −1 −1 −1 −1 −1 −1 1 1 1 −1 −1 1 1 −1 1 |
| | −1 −1 1 1 −1 −1 1 −1 1 −1 −1 1 1 −1 −1 −1 −1 1 1 −1 −1 1 1 1 1 1 1 1 1 −1 −1 1 |
| | 1 1 1 1 1 −1 −1 1 1 1 −1 1 −1 −1 1 1 −1 1 −1 1 −1 −1 1 1 −1 1 1 −1 −1 −1 −1 −1 |
| | −1 1 1 −1 −1 −1 −1 −1 −1 −1 1 1 −1 1 −1 1 −1 −1 1 1 −1 1 −1 1 −1 1 1 1 1 −1 −1 |
| | 1 1 1 1 1 1 −1 −1 1 1 1 −1 1 −1 −1 1 1 −1 1 −1 1 −1 −1 1 1 −1 1 1 −1 −1 −1 −1 |
| | −1 −1 1 1 −1 −1 −1 −1 −1 −1 −1 1 1 −1 1 −1 1 −1 −1 1 1 −1 1 −1 1 −1 1 −1 1 −1 |
| | −1 1 1 −1 −1 1 −1 1 1 −1 −1 1 1 1 1 1 −1 −1 1 1 −1 −1 −1 −1 1 1 −1 −1 1 −1 −1 |
| | 1 −1 1 −1 1 −1 1 1 −1 1 −1 1 −1 −1 −1 1 1 1 1 1 1 1 1 −1 −1 −1 −1 −1 −1 1 −1 1 |
| | −1 −1 1 1 −1 −1 1 −1 1 1 −1 −1 1 1 1 1 1 −1 −1 1 1 −1 −1 −1 −1 1 1 −1 −1 1 −1 |
| | −1 1 −1 1 −1 1 −1 1 1 −1 1 −1 1 −1 −1 −1 1 1 1 1 1 1 1 1 −1 −1 −1 −1 −1 −1 1 1 |
| | 1 1 1 1 −1 −1 −1 −1 −1 −1 −1 −1 1 1 1 −1 1 −1 1 −1 −1 1 −1 1 −1 1 −1 1 1 −1 1 |
| | 1 −1 −1 1 1 1 1 −1 −1 1 1 −1 −1 −1 −1 −1 1 1 −1 −1 1 −1 1 1 −1 −1 1 1 −1 1 −1 |
| | −1 −1 −1 −1 −1 −1 1 1 1 1 1 1 1 1 −1 −1 −1 1 −1 1 −1 1 1 −1 1 −1 1 −1 1 −1 −1 |
| | 1 −1 −1 1 1 −1 −1 −1 −1 1 1 −1 −1 1 1 1 1 1 −1 −1 1 1 −1 1 −1 −1 1 1 −1 −1 1 |
| | −1 1 1 −1 1 −1 1 −1 −1 1 1 −1 1 −1 1 −1 −1 1 1 1 1 1 1 1 −1 −1 1 1 1 1 1 −1 −1 |
| | 1 −1 −1 1 1 −1 1 −1 1 −1 −1 1 1 −1 1 −1 −1 −1 1 1 −1 −1 −1 −1 −1 −1 1 1 −1 −1 |
| | −1 −1 −1 1 −1 1 −1 1 1 −1 −1 1 −1 1 −1 1 1 −1 −1 −1 −1 −1 −1 −1 1 1 −1 −1 −1 |
| | −1 −1 −1 1 1 −1 1 1 −1 −1 1 −1 1 −1 1 1 −1 −1 1 −1 1 1 1 −1 −1 1 1 1 1 1 1 −1 |
| | −1 1 1 1 1 1 1 1 1 −1 −1 1 1 −1 −1 −1 −1 1 1 −1 −1 1 −1 1 −1 −1 1 1 −1 −1 1 −1 |
| | 1 1 −1 −1 1 1 1 −1 −1 −1 −1 −1 −1 −1 −1 1 1 1 1 1 1 −1 1 1 −1 1 −1 1 −1 1 −1 |
| | −1 1 −1 1 −1 1 −1 −1 −1 −1 1 1 −1 −1 1 1 1 1 −1 −1 1 1 −1 1 −1 1 1 −1 −1 1 1 |
| | −1 1 −1 −1 1 1 −1 −1 −1 1 1 1 1 1 1 1 1 −1 −1 −1 −1 −1 −1 1 −1 −1 1 −1 1 −1 1 |
| | −1 1 1 −1 1 −1 1 −1 1 −1 1 −1 −1 1 1 −1 1 −1 1 −1 −1 1 1 −1 1 1 1 1 −1 −1 1 1 1 |
| | 1 1 1 −1 −1 1 1 1 −1 −1 1 −1 1 −1 1 1 −1 −1 1 −1 1 −1 1 −1 −1 1 1 1 1 1 1 −1 −1 |
| | 1 1 1 1 1 1 −1 1 −1 1 1 −1 −1 1 −1 1 −1 1 1 −1 −1 1 −1 −1 −1 −1 1 1 −1 −1 −1 |
| | −1 −1 −1 1 1 −1 −1 −1 1 1 −1 1 −1 1 −1 −1 1 1 −1 1 −1 1 −1 1 1 −1 −1 −1 −1 −1 |
| | −1 1 1 −1 −1 −1 −1 −1 −1 −1 −1 −1 −1 −1 −1 1 1 −1 −1 −1 −1 −1 −1 1 1 −1 1 −1 |
| | 1 −1 1 1 −1 −1 1 −1 1 −1 1 1 −1 −1 −1 1 1 −1 −1 −1 −1 −1 −1 1 1 −1 −1 −1 −1 1 |
| | −1 −1 1 1 −1 1 −1 1 −1 −1 1 1 −1 1 −1 1 1 1 1 1 1 −1 −1 1 1 1 1 1 1 −1 −1 1 −1 1 |
| | −1 1 −1 −1 1 1 −1 1 −1 1 −1 −1 1 1 1 −1 −1 1 1 1 1 1 1 −1 −1 1 1 1 1 −1 1 1 −1 |
| | −1 1 −1 1 −1 1 1 −1 −1 1 −1 1 −1 1 −1 1 −1 1 1 −1 1 −1 1 −1 1 −1 −1 1 −1 −1 −1 |
| | −1 −1 −1 1 1 1 1 1 1 1 1 −1 −1 −1 1 1 −1 −1 1 −1 1 1 −1 −1 1 1 −1 1 −1 1 1 −1 |
| | −1 1 1 1 1 −1 −1 1 1 −1 −1 −1 −1 1 −1 1 −1 1 −1 −1 1 −1 1 −1 1 −1 1 1 −1 1 1 1 |
| | 1 1 1 −1 −1 −1 −1 −1 −1 −1 −1 1 1 1 −1 −1 1 1 −1 1 −1 −1 1 1 −1 −1 1 −1 1 −1 |
| | −1 1 1 −1 −1 −1 −1 1 1 −1 −1 1 1 1 1 −1 −1 −1 −1 1 1 −1 −1 −1 −1 −1 −1 1 1 −1 |
| | −1 −1 1 −1 1 1 −1 −1 1 −1 1 −1 1 1 −1 −1 1 −1 −1 1 1 1 1 1 1 −1 −1 1 1 1 1 1 1 1 |
| | −1 −1 1 −1 1 −1 1 1 −1 −1 1 −1 1 −1 1 1 1 1 1 −1 −1 1 1 1 1 1 1 −1 −1 1 1 1 −1 1 |
| | −1 −1 1 1 −1 1 −1 1 −1 −1 1 1 −1 1 1 −1 −1 −1 −1 −1 −1 1 1 −1 −1 −1 −1 −1 −1 |
| | −1 1 1 −1 1 −1 1 −1 −1 1 1 −1 1 −1 1 −1 −1 1 −1 1 1 −1 −1 1 1 −1 1 −1 −1 1 1 |
| | −1 −1 −1 −1 −1 1 1 −1 −1 1 1 1 1 −1 −1 1 1 −1 1 1 −1 1 −1 1 −1 1 −1 −1 1 −1 1 |
| | −1 1 1 1 −1 −1 −1 −1 −1 −1 −1 −1 1 1 1 1 1 1 1 −1 1 −1 −1 1 1 −1 −1 1 −1 1 1 |
| | −1 −1 1 1 1 1 1 −1 −1 1 1 −1 −1 −1 −1 1 1 −1 −1 1 −1 −1 1 −1 1 −1 1 −1 1 1 −1 |
| | 1 −1 1 −1 −1 −1 1 1 1 1 1 1 1 1 −1 −1 −1 −1 −1 −1 −1 −1 −1 −1 −1 −1 1 1 1 1 1 |
| | 1 1 1 −1 −1 −1 1 −1 1 −1 1 1 −1 1 −1 1 −1 1 −1 −1 1 −1 −1 1 1 −1 −1 −1 −1 1 1 |
| | −1 −1 1 1 1 −1 −1 1 1 −1 1 −1 −1 1 1 −1 −1 1 −1 1 −1 −1 −1 −1 −1 −1 1 1 1 |
| | 1 1 1 1 1 −1 −1 −1 1 −1 1 −1 1 1 −1 1 −1 1 −1 1 −1 −1 1 −1 −1 1 1 −1 −1 −1 −1 |
| | 1 1 −1 −1 1 1 1 1 1 −1 −1 1 1 −1 1 −1 −1 1 1 −1 −1 1 −1 1 −1 1 −1 1 −1 1 1 −1 |
| | −1 1 −1 1 −1 1 1 −1 −1 −1 −1 −1 −1 −1 1 1 −1 −1 −1 −1 −1 −1 1 1 −1 1 1 −1 −1 |
| | 1 −1 1 −1 1 1 −1 −1 1 −1 1 1 1 −1 −1 1 1 1 1 1 1 −1 −1 1 1 1 1 −1 1 −1 1 −1 1 1 |
| | −1 −1 1 −1 1 −1 1 1 −1 −1 −1 −1 −1 −1 −1 1 1 −1 −1 −1 −1 −1 −1 1 1 −1 1 1 −1 |
| | −1 1 −1 1 −1 1 1 −1 −1 1 −1 1 1 1 −1 −1 1 1 1 1 1 1 −1 −1 1 1 1 1 −1 −1 −1 −1 1 |
| | 1 −1 −1 1 1 1 1 −1 −1 1 1 −1 1 −1 1 1 −1 −1 1 1 −1 1 −1 −1 1 1 −1 −1 −1 1 1 1 1 |
| | 1 1 1 1 −1 −1 −1 −1 −1 −1 1 −1 −1 1 −1 1 −1 1 −1 1 1 −1 1 −1 1 −1 −1 −1 −1 −1 |
| | 1 1 −1 −1 1 1 1 1 −1 −1 1 1 −1 1 −1 1 1 −1 −1 1 1 −1 1 −1 −1 1 1 −1 −1 −1 1 1 1 |
| | 1 1 1 1 1 −1 −1 −1 −1 −1 −1 1 −1 −1 1 −1 1 −1 1 −1 1 1 −1 1 −1 1 −1 −1 1 −1 1 |
| | 1 −1 −1 1 −1 1 −1 1 1 −1 −1 1 −1 −1 −1 −1 1 1 −1 −1 −1 −1 −1 −1 1 1 −1 −1 −1 |
| | 1 1 −1 1 −1 1 −1 −1 1 1 −1 1 −1 1 −1 1 1 −1 −1 −1 −1 −1 −1 1 1 −1 −1 −1 −1 −1 |
| | −1 −1 1 −1 1 1 −1 −1 1 −1 1 −1 1 1 −1 −1 1 −1 −1 −1 −1 1 1 −1 −1 −1 −1 −1 −1 |
| | 1 1 −1 −1 −1 1 1 −1 1 −1 1 −1 −1 1 1 −1 1 −1 1 −1 1 1 −1 −1 −1 −1 −1 −1 1 1 −1 |
| | −1 −1 −1 −1 −1 |
| 4 | 1 1 1 1 1 −1 1 −1 1 1 1 1 1 −1 1 −1 1 1 −1 −1 1 −1 −1 1 1 1 −1 −1 1 −1 −1 1 1 1 |
| | 1 1 1 −1 1 −1 −1 −1 −1 −1 −1 1 −1 1 1 1 −1 −1 1 −1 −1 1 −1 −1 1 1 −1 1 1 −1 1 |
| | 1 −1 −1 1 −1 −1 1 1 1 −1 −1 1 −1 −1 1 1 1 1 1 1 −1 1 −1 1 1 1 1 1 −1 1 −1 1 1 −1 |
| | −1 1 −1 −1 1 −1 −1 1 1 −1 1 1 −1 1 1 1 1 1 −1 1 −1 −1 −1 −1 −1 −1 1 −1 1 1 −1 |
| | 1 −1 1 1 1 1 1 −1 1 −1 1 1 1 1 −1 −1 1 1 1 −1 −1 1 −1 −1 1 1 1 −1 −1 1 −1 1 −1 |
| | 1 1 1 1 −1 1 −1 1 −1 −1 −1 −1 1 −1 −1 1 1 1 −1 −1 −1 1 1 −1 −1 −1 1 1 1 −1 −1 |
| | 1 1 1 −1 −1 1 −1 −1 1 1 1 −1 −1 1 −1 1 −1 1 1 1 1 1 −1 1 −1 1 1 1 1 1 −1 −1 1 1 |
| | 1 −1 −1 −1 1 1 −1 −1 −1 1 1 1 −1 1 −1 1 1 1 1 −1 1 −1 1 −1 −1 −1 −1 1 1 1 1 −1 |
| | 1 −1 1 1 1 1 1 −1 1 −1 1 −1 −1 1 1 1 −1 −1 1 −1 −1 1 1 1 −1 −1 1 1 1 1 1 −1 1 −1 |
| | 1 −1 −1 −1 −1 1 −1 1 −1 −1 −1 1 1 1 −1 −1 1 1 1 −1 −1 −1 1 1 −1 1 1 −1 −1 −1 1 |
| | 1 −1 1 1 −1 −1 −1 1 1 −1 −1 −1 −1 −1 1 −1 1 −1 −1 −1 −1 −1 1 −1 1 −1 1 1 −1 |
| | −1 −1 1 1 −1 −1 −1 1 1 1 −1 −1 1 −1 −1 −1 −1 1 −1 1 −1 1 1 1 1 −1 1 −1 1 1 −1 |
| | 1 −1 −1 −1 −1 −1 1 −1 1 −1 −1 −1 −1 −1 −1 1 1 −1 1 1 −1 −1 −1 1 1 −1 1 1 −1 |
| | −1 1 −1 1 −1 −1 −1 −1 −1 −1 1 −1 1 1 1 1 1 −1 1 1 −1 1 1 −1 −1 1 −1 −1 1 −1 −1 |
| | 1 1 1 −1 −1 1 −1 −1 1 1 1 −1 −1 1 −1 −1 1 1 −1 1 −1 1 1 1 1 1 −1 1 −1 1 1 1 1 1 |
| | 1 −1 −1 1 −1 −1 1 1 −1 1 −1 1 1 −1 −1 −1 1 −1 1 1 1 1 1 1 −1 1 −1 −1 −1 −1 |
| | −1 1 1 1 1 1 −1 1 −1 1 1 1 1 1 −1 1 −1 1 1 −1 −1 1 −1 −1 1 1 1 −1 −1 1 −1 −1 1 |
| | −1 −1 −1 −1 −1 1 −1 1 1 1 1 1 1 −1 1 −1 −1 −1 1 1 −1 1 1 −1 1 1 −1 −1 1 −1 −1 |
| | 1 1 1 −1 −1 1 −1 −1 1 1 1 −1 −1 1 −1 −1 1 1 1 1 1 1 −1 1 −1 1 1 1 1 1 −1 1 −1 −1 |
| | −1 1 1 −1 1 1 −1 1 1 −1 −1 1 −1 −1 1 −1 −1 −1 −1 −1 1 −1 1 1 1 1 1 1 −1 1 −1 |
| | −1 1 −1 1 −1 −1 −1 −1 −1 1 −1 1 −1 −1 −1 −1 −1 1 1 −1 −1 −1 1 1 −1 1 1 −1 −1 |
| | −1 1 1 1 −1 1 −1 1 1 1 1 −1 1 −1 1 −1 −1 −1 −1 1 −1 −1 1 1 1 −1 −1 −1 1 1 −1 |
| | −1 −1 1 1 −1 1 1 −1 −1 −1 1 1 −1 1 1 −1 −1 −1 1 1 −1 1 −1 1 −1 −1 −1 −1 −1 1 |
| | −1 1 −1 −1 −1 −1 1 −1 −1 1 1 1 −1 −1 −1 1 1 −1 −1 −1 1 1 1 −1 1 −1 1 1 1 1 −1 |
| | 1 −1 1 −1 −1 −1 −1 1 1 1 1 −1 1 −1 1 1 1 1 1 −1 1 −1 1 −1 −1 1 1 1 −1 −1 1 −1 |
| | −1 1 1 1 −1 −1 1 −1 −1 −1 −1 1 −1 1 −1 1 1 1 1 −1 1 −1 1 1 1 −1 −1 −1 1 1 −1 |
| | −1 −1 1 1 1 −1 −1 1 1 1 −1 −1 −1 1 1 −1 1 1 −1 −1 −1 1 1 −1 −1 −1 −1 −1 1 −1 1 |
| | −1 −1 −1 −1 −1 1 −1 1 −1 −1 −1 1 1 1 −1 −1 1 1 1 −1 −1 −1 1 1 −1 1 1 1 1 −1 1 |
| | −1 1 −1 −1 −1 −1 1 −1 1 −1 −1 1 −1 1 1 1 1 1 −1 1 −1 1 1 1 1 1 1 −1 −1 1 −1 −1 |
| | 1 1 1 −1 −1 1 −1 −1 1 1 1 −1 1 −1 −1 −1 −1 −1 −1 1 −1 1 1 1 1 1 −1 1 1 −1 1 1 |
| | −1 −1 1 −1 −1 1 −1 −1 1 1 −1 1 1 −1 1 1 −1 −1 −1 1 1 −1 1 1 −1 −1 1 −1 1 −1 −1 |
| | −1 −1 −1 1 −1 1 −1 −1 −1 −1 −1 1 −1 −1 1 −1 −1 1 1 −1 1 1 −1 1 1 −1 −1 −1 1 |
| | −1 1 1 1 1 1 1 −1 1 −1 −1 −1 −1 −1 1 1 1 1 1 −1 1 −1 −1 −1 −1 −1 −1 1 −1 1 1 1 |
| | −1 −1 1 −1 −1 1 −1 −1 1 1 −1 1 1 −1 1 1 1 1 1 −1 1 −1 1 1 1 1 1 −1 1 −1 1 1 −1 |
| | −1 1 −1 −1 1 1 1 −1 −1 1 −1 −1 1 1 1 −1 −1 1 −1 −1 1 −1 −1 1 1 −1 1 1 −1 1 1 1 |
| | 1 1 −1 1 −1 −1 −1 −1 −1 −1 1 −1 1 1 1 −1 −1 1 −1 −1 1 1 1 −1 −1 1 −1 −1 1 1 1 |
| | 1 1 1 −1 1 −1 1 1 1 1 1 −1 1 −1 1 −1 1 −1 1 1 1 1 −1 1 −1 1 −1 −1 −1 −1 1 −1 −1 |
| | 1 1 1 −1 −1 −1 1 1 −1 −1 −1 1 1 1 −1 1 −1 1 1 1 1 1 −1 1 −1 1 1 1 1 1 −1 −1 1 1 |
| | 1 −1 −1 1 −1 −1 1 1 1 −1 −1 1 −1 −1 1 1 1 −1 −1 −1 1 1 −1 −1 −1 1 1 1 −1 1 −1 |
| | 1 1 1 1 −1 1 −1 1 −1 −1 −1 −1 1 −1 −1 1 1 1 −1 −1 1 −1 −1 1 1 1 −1 −1 1 −1 1 |
| | −1 1 1 1 1 1 −1 1 −1 1 1 1 1 1 1 1 1 −1 1 −1 1 −1 −1 −1 −1 1 −1 1 −1 −1 −1 1 1 1 |
| | −1 −1 1 1 1 −1 −1 −1 1 1 −1 1 1 1 1 −1 1 −1 1 1 1 1 1 −1 1 −1 1 −1 −1 1 1 1 −1 |
| | −1 1 −1 −1 1 1 1 −1 −1 1 1 1 −1 −1 −1 1 1 −1 −1 −1 1 1 1 −1 −1 1 −1 −1 −1 −1 1 |
| | −1 1 −1 1 1 1 1 −1 1 −1 1 1 1 −1 −1 −1 1 1 −1 1 1 −1 −1 −1 1 1 −1 −1 −1 −1 −1 |
| | 1 −1 1 −1 −1 −1 −1 −1 1 −1 1 −1 1 −1 1 −1 −1 −1 −1 −1 −1 1 −1 1 1 1 1 1 −1 1 1 |
| | −1 1 1 −1 −1 1 −1 −1 1 −1 −1 1 1 1 −1 1 −1 −1 −1 −1 −1 1 −1 1 −1 −1 −1 −1 −1 |
| | −1 1 1 −1 1 1 −1 −1 −1 1 1 −1 1 1 −1 −1 1 −1 −1 1 −1 −1 1 1 −1 1 1 −1 1 1 −1 |
| | −1 −1 1 −1 1 1 1 1 1 1 −1 1 −1 −1 −1 −1 −1 1 −1 −1 1 −1 −1 1 1 1 −1 −1 1 −1 −1 |
| | 1 1 −1 1 −1 1 1 1 1 1 −1 1 −1 1 1 1 1 1 1 1 1 1 1 −1 1 −1 −1 −1 −1 −1 −1 1 −1 1 |
| | 1 1 −1 −1 1 −1 −1 1 −1 −1 1 1 −1 1 1 −1 −1 −1 −1 −1 −1 1 −1 1 −1 −1 −1 −1 −1 |
| | 1 −1 1 −1 −1 1 1 −1 1 1 −1 −1 −1 1 1 −1 1 1 −1 1 1 −1 −1 1 −1 −1 1 −1 −1 1 1 |
| | −1 1 1 −1 1 1 1 1 1 −1 1 −1 −1 −1 −1 −1 −1 1 −1 1 −1 −1 1 1 −1 1 1 −1 −1 −1 1 |
| | 1 −1 1 1 −1 −1 −1 −1 −1 −1 1 −1 1 −1 −1 −1 −1 −1 1 −1 1 −1 1 −1 1 −1 −1 −1 |
| | −1 1 −1 1 −1 1 1 1 1 −1 1 1 −1 −1 −1 1 1 1 −1 −1 1 1 1 −1 −1 1 −1 1 −1 1 1 1 1 1 |
| | −1 1 −1 1 1 1 1 1 −1 −1 1 1 1 −1 −1 1 −1 −1 1 1 1 −1 −1 −1 1 1 −1 −1 −1 1 1 1 |
| | −1 −1 1 1 1 −1 −1 −1 1 −1 1 −1 −1 −1 −1 1 −1 1 −1 1 1 1 1 1 −1 −1 1 1 1 −1 −1 |
| | 1 −1 −1 1 1 1 −1 −1 1 −1 1 −1 1 1 1 1 1 −1 1 −1 1 1 1 1 1 1 1 1 −1 1 −1 1 −1 −1 |
| | −1 −1 1 −1 1 −1 −1 −1 1 1 1 −1 −1 1 1 1 −1 −1 −1 1 1 −1 −1 −1 −1 −1 1 −1 1 −1 |
| | −1 −1 −1 −1 1 −1 1 −1 1 1 −1 −1 −1 1 1 −1 1 1 −1 −1 −1 1 1 −1 1 1 −1 −1 −1 1 1 |
| | −1 −1 −1 1 1 1 −1 −1 1 −1 −1 −1 −1 1 −1 1 −1 1 1 1 1 −1 1 −1 1 −1 −1 1 1 1 −1 |
| | −1 1 −1 −1 1 1 1 −1 −1 1 1 1 1 1 −1 1 −1 1 1 1 1 1 −1 1 −1 1 −1 1 −1 1 1 1 1 1 1 |
| | −1 1 −1 −1 −1 −1 −1 1 −1 −1 1 −1 −1 1 1 −1 1 1 −1 1 1 −1 −1 1 −1 1 −1 −1 −1 |
| | −1 −1 1 −1 1 −1 −1 −1 −1 −1 −1 1 1 −1 1 1 −1 −1 −1 1 1 −1 1 1 −1 −1 −1 1 1 −1 |
| | 1 1 −1 −1 1 −1 −1 1 −1 −1 1 1 1 −1 1 −1 −1 −1 −1 −1 −1 1 −1 1 1 1 1 1 1 −1 −1 |
| | 1 −1 −1 1 1 1 −1 −1 1 −1 −1 1 1 −1 1 −1 1 1 1 1 1 −1 1 −1 1 1 1 1 1 1 1 1 1 1 −1 |
| | 1 −1 1 1 1 1 1 −1 1 −1 1 1 −1 −1 1 −1 −1 1 1 1 −1 −1 1 −1 −1 1 1 1 1 1 1 −1 1 −1 |
| | −1 −1 −1 −1 −1 1 −1 1 1 1 −1 −1 1 −1 −1 1 −1 −1 1 1 −1 1 1 −1 1 1 −1 −1 1 −1 |
| | −1 1 1 1 −1 −1 1 −1 −1 1 1 1 1 1 1 −1 1 −1 1 1 1 1 1 −1 1 −1 1 1 −1 −1 1 −1 −1 1 |
| | −1 −1 1 1 −1 1 1 −1 1 1 1 1 1 −1 1 −1 −1 −1 −1 −1 −1 1 −1 1 1 −1 1 −1 1 1 1 1 1 |
| | −1 1 −1 1 1 1 1 1 −1 −1 1 1 1 −1 −1 1 −1 −1 1 1 1 −1 −1 1 −1 1 −1 1 1 1 1 −1 1 |
| | −1 1 −1 −1 −1 1 −1 −1 1 1 1 −1 −1 −1 1 1 −1 −1 −1 1 1 1 −1 −1 1 1 1 −1 −1 1 |
| | −1 −1 1 1 1 −1 −1 1 −1 1 −1 1 1 1 1 1 −1 1 −1 1 1 1 1 1 −1 −1 1 1 1 −1 −1 −1 1 1 |
| | −1 −1 −1 1 1 1 −1 1 −1 1 1 1 1 −1 1 −1 1 −1 −1 −1 −1 1 1 1 1 −1 1 −1 1 1 1 1 1 |
| | −1 1 −1 1 −1 −1 1 1 1 −1 −1 1 −1 −1 1 1 1 −1 −1 1 1 1 1 1 −1 1 −1 1 −1 −1 −1 |
| | −1 1 −1 1 −1 −1 −1 1 1 1 −1 −1 1 1 1 −1 −1 −1 1 1 −1 1 1 −1 −1 −1 1 1 −1 1 1 |
| | −1 −1 −1 1 1 −1 −1 −1 −1 −1 1 −1 1 −1 −1 −1 −1 −1 1 −1 1 −1 1 1 −1 −1 −1 1 1 |
| | −1 −1 −1 1 1 1 −1 −1 1 −1 −1 −1 −1 1 −1 1 −1 1 1 1 1 −1 1 −1 1 1 −1 1 −1 −1 −1 |
| | −1 −1 1 −1 1 −1 −1 −1 −1 −1 −1 1 1 −1 1 1 −1 −1 −1 1 1 −1 1 1 −1 −1 1 −1 1 −1 |
| | −1 −1 −1 −1 −1 1 −1 1 1 1 1 1 −1 1 1 −1 1 1 −1 −1 1 −1 −1 1 −1 −1 1 1 1 −1 −1 |
| | 1 −1 −1 1 1 1 −1 −1 1 −1 −1 1 1 −1 1 −1 1 1 1 1 1 −1 1 −1 1 1 1 1 1 1 −1 −1 1 −1 |
| | −1 1 1 −1 1 1 −1 1 1 −1 −1 −1 1 −1 1 1 1 1 1 1 −1 1 −1 −1 −1 −1 −1 1 1 1 1 1 −1 |
| | 1 −1 1 1 1 1 1 −1 1 −1 1 1 −1 −1 1 −1 −1 1 1 1 −1 −1 1 −1 −1 1 −1 −1 −1 −1 −1 |
| | 1 −1 1 1 1 1 1 1 −1 1 −1 −1 −1 1 1 −1 1 1 −1 1 1 −1 −1 1 −1 −1 1 1 1 −1 −1 1 −1 |
| | −1 1 1 1 −1 −1 1 −1 −1 1 1 1 1 1 1 −1 1 −1 1 1 1 1 1 −1 1 −1 −1 −1 1 1 −1 1 1 −1 |
| | 1 1 −1 −1 1 −1 −1 1 −1 −1 −1 −1 −1 1 −1 1 1 1 1 1 1 −1 1 −1 −1 1 −1 1 −1 −1 −1 |
| | −1 −1 1 −1 1 −1 −1 −1 −1 −1 1 1 −1 −1 −1 1 1 −1 1 1 −1 −1 −1 1 1 1 −1 1 −1 1 1 |
| | 1 1 −1 1 −1 1 −1 −1 −1 −1 1 −1 −1 1 1 1 −1 −1 −1 1 1 −1 −1 −1 1 1 −1 1 1 −1 −1 |
| | −1 1 1 −1 1 1 −1 −1 −1 1 1 −1 1 −1 1 −1 −1 −1 −1 −1 1 −1 1 −1 −1 −1 −1 1 −1 |
| | −1 1 1 1 −1 −1 −1 1 1 −1 −1 −1 1 1 1 −1 1 −1 1 1 1 1 −1 1 −1 1 −1 −1 −1 −1 1 1 |
| | 1 1 −1 1 −1 1 1 1 1 1 −1 1 −1 1 −1 −1 1 1 1 −1 −1 1 −1 −1 1 1 1 −1 −1 1 −1 −1 |
| | −1 −1 1 −1 1 −1 1 1 1 1 −1 1 −1 1 1 1 −1 −1 −1 1 1 −1 −1 −1 1 1 1 −1 −1 1 1 1 |
| | −1 −1 −1 1 1 −1 1 1 −1 −1 −1 1 1 −1 −1 −1 −1 −1 1 −1 1 −1 −1 −1 −1 −1 1 −1 1 |
| | −1 −1 −1 1 1 1 −1 −1 1 1 1 −1 −1 −1 1 1 −1 1 1 1 1 −1 1 −1 1 −1 −1 −1 −1 1 −1 |
| | 1 −1 −1 1 −1 1 1 1 1 1 −1 1 −1 1 1 1 1 1 1 −1 −1 1 −1 −1 1 1 1 −1 −1 1 −1 −1 1 1 |
| | 1 −1 1 −1 −1 −1 −1 −1 −1 1 −1 1 1 1 1 1 −1 1 1 −1 1 1 −1 −1 1 −1 −1 1 −1 −1 1 |
| | 1 −1 1 1 −1 1 1 −1 −1 −1 1 1 −1 1 1 −1 −1 1 −1 1 −1 −1 −1 −1 −1 1 −1 1 −1 −1 |
| | −1 −1 −1 1 −1 −1 1 −1 −1 1 1 −1 1 1 −1 1 1 −1 −1 −1 1 −1 1 1 1 1 1 1 −1 1 −1 |
| | −1 −1 −1 −1 −1 −1 −1 −1 −1 1 −1 1 1 1 1 1 1 −1 1 −1 −1 −1 1 1 −1 1 1 −1 1 1 −1 |
| | −1 1 −1 −1 1 −1 −1 −1 −1 −1 1 −1 1 −1 −1 −1 −1 −1 1 −1 1 −1 −1 1 1 −1 1 1 −1 |
| | −1 −1 1 1 −1 1 1 −1 −1 −1 1 1 −1 1 1 −1 1 1 −1 −1 1 −1 −1 1 −1 −1 −1 −1 −1 1 |
| | −1 1 1 1 1 1 1 −1 1 −1 −1 −1 1 1 −1 1 1 −1 −1 −1 1 1 −1 1 1 −1 −1 −1 −1 −1 −1 |
| | 1 −1 1 −1 −1 −1 −1 −1 1 −1 1 −1 1 −1 1 −1 −1 −1 −1 1 −1 1 −1 1 1 1 1 −1 1 1 −1 |
| | −1 −1 1 1 1 −1 −1 1 1 1 −1 −1 −1 1 −1 1 −1 −1 −1 −1 −1 1 −1 1 −1 −1 −1 −1 −1 |
| | 1 1 −1 −1 −1 1 1 −1 1 1 −1 −1 −1 1 1 −1 1 1 −1 −1 −1 1 1 1 −1 −1 1 1 1 −1 −1 |
| | −1 1 −1 1 −1 −1 −1 −1 1 −1 1 −1 1 1 1 1 −1 1 1 −1 −1 −1 1 1 −1 1 1 −1 −1 −1 1 |
| | 1 −1 1 −1 1 −1 −1 −1 −1 −1 1 −1 1 −1 −1 −1 −1 −1 −1 −1 −1 1 −1 1 −1 1 1 1 1 |
| | −1 1 −1 1 1 1 −1 −1 −1 1 1 −1 −1 −1 1 1 1 −1 −1 1 −1 −1 −1 −1 1 −1 1 −1 −1 −1 |
| | −1 −1 1 −1 1 −1 1 1 −1 −1 −1 1 1 −1 1 1 −1 −1 −1 1 1 −1 −1 −1 1 1 1 −1 −1 1 1 |
| | 1 −1 −1 −1 1 1 −1 1 1 1 1 −1 1 −1 1 −1 −1 −1 −1 1 −1 1 −1 −1 −1 1 1 1 −1 −1 1 |
| | −1 −1 1 1 1 −1 −1 1 1 1 1 1 −1 1 −1 1 1 1 1 1 −1 1 −1 1 −1 1 −1 1 1 1 1 1 1 −1 1 |
| | −1 −1 −1 −1 −1 1 −1 −1 1 −1 −1 1 1 −1 1 1 −1 1 1 −1 −1 −1 1 −1 1 1 1 1 1 −1 1 |
| | −1 1 1 1 1 1 1 −1 −1 1 −1 −1 1 1 1 −1 −1 1 −1 −1 1 1 −1 1 1 −1 1 1 −1 −1 1 −1 |
| | −1 1 −1 −1 1 1 1 −1 1 −1 −1 −1 −1 −1 −1 1 −1 1 1 1 1 1 −1 1 1 −1 1 1 −1 −1 −1 |
| | 1 1 −1 1 1 −1 −1 1 −1 1 −1 −1 −1 −1 −1 1 −1 1 −1 −1 −1 −1 −1 −1 −1 −1 −1 −1 |
| | 1 −1 1 1 1 1 1 1 −1 1 −1 −1 −1 1 1 −1 1 1 −1 1 1 −1 −1 1 −1 −1 1 1 1 1 1 1 −1 1 |
| | −1 1 1 1 1 1 −1 1 −1 1 1 −1 −1 1 −1 −1 1 1 1 −1 −1 1 −1 −1 1 −1 −1 1 1 −1 1 1 |
| | −1 1 1 −1 −1 1 −1 −1 1 −1 −1 −1 −1 −1 1 −1 1 1 1 1 1 1 −1 1 −1 1 1 −1 −1 1 −1 |
| | −1 1 1 1 −1 −1 1 −1 −1 1 1 1 1 1 1 −1 1 −1 1 1 1 1 1 −1 1 −1 1 −1 1 −1 1 1 1 1 |
| | −1 1 −1 1 −1 −1 −1 −1 1 −1 −1 1 1 1 −1 −1 −1 1 1 −1 −1 −1 1 1 −1 1 −1 1 −1 −1 |
| | −1 −1 −1 1 −1 1 −1 −1 −1 −1 −1 1 1 −1 −1 −1 1 1 −1 1 1 −1 −1 −1 1 1 1 −1 −1 1 |
| | 1 1 −1 −1 −1 1 1 −1 −1 −1 1 1 1 −1 1 −1 1 1 1 1 −1 1 −1 1 −1 −1 −1 −1 −1 1 1 |
| | −1 −1 −1 1 1 −1 1 1 −1 −1 −1 1 1 −1 1 −1 1 −1 −1 −1 −1 −1 1 −1 1 −1 −1 −1 −1 |
| | −1 −1 −1 −1 1 −1 1 −1 1 1 1 1 −1 1 −1 1 1 1 −1 −1 −1 1 1 −1 −1 −1 1 1 1 −1 −1 |
| | 1 1 1 1 1 −1 1 −1 1 1 1 1 1 −1 1 −1 1 −1 −1 1 1 1 −1 −1 1 −1 −1 1 1 1 −1 −1 1 −1 |
| | −1 1 1 1 −1 −1 1 1 1 −1 −1 −1 1 1 −1 1 1 1 −1 1 −1 1 −1 −1 −1 −1 1 −1 1 −1 1 |
| | 1 −1 −1 −1 1 1 −1 1 1 −1 −1 −1 1 1 −1 −1 −1 −1 −1 1 −1 1 −1 −1 −1 −1 −1 1 −1 |
| | 1 −1 1 −1 1 −1 −1 −1 −1 −1 −1 1 −1 1 1 1 1 1 −1 1 1 −1 1 1 −1 −1 1 −1 −1 1 −1 |
| | −1 1 1 −1 1 −1 1 1 1 1 1 −1 1 −1 1 1 1 1 1 1 −1 −1 1 −1 −1 1 1 1 −1 −1 1 −1 −1 1 |
| | 1 1 −1 −1 1 −1 −1 1 1 −1 1 1 −1 1 1 −1 −1 −1 1 −1 1 1 1 1 1 1 −1 1 −1 −1 −1 −1 |
| | −1 −1 1 1 −1 1 1 −1 −1 −1 1 1 −1 1 1 −1 −1 1 −1 1 −1 −1 −1 −1 −1 1 −1 1 −1 −1 |
| | −1 −1 −1 −1 −1 −1 −1 −1 1 −1 1 −1 −1 −1 −1 −1 1 −1 1 −1 −1 1 1 −1 1 1 −1 −1 |
| | −1 1 1 −1 1 1 −1 −1 −1 −1 −1 −1 1 −1 1 1 1 1 1 1 −1 1 −1 −1 −1 1 1 −1 1 1 −1 1 |
| | 1 −1 −1 1 −1 −1 1 −1 −1 1 1 −1 1 1 −1 −1 −1 1 1 −1 1 1 −1 −1 −1 −1 −1 −1 1 −1 |
| | 1 −1 −1 −1 −1 −1 1 −1 1 −1 −1 1 1 −1 1 1 −1 1 1 −1 −1 1 −1 −1 1 −1 −1 −1 −1 |
| | −1 1 −1 1 1 1 1 1 1 −1 1 −1 −1 1 −1 1 −1 −1 −1 −1 −1 1 −1 1 −1 −1 −1 −1 −1 1 1 |
| | −1 −1 −1 1 1 −1 1 1 −1 −1 −1 1 1 −1 1 −1 1 −1 −1 −1 −1 1 −1 1 −1 1 1 1 1 −1 1 |
| | 1 −1 −1 −1 1 1 1 −1 −1 1 1 1 −1 −1 −1 1 1 −1 −1 −1 1 1 −1 1 1 −1 −1 −1 1 1 −1 |
| | 1 −1 1 −1 −1 −1 −1 −1 1 −1 1 −1 −1 −1 −1 −1 1 1 −1 −1 −1 1 1 1 −1 −1 1 1 1 −1 |
| | −1 −1 1 −1 1 −1 −1 −1 −1 1 −1 1 −1 1 1 1 1 −1 −1 −1 −1 1 −1 1 −1 −1 −1 −1 −1 |
| | 1 −1 1 −1 1 1 −1 −1 −1 1 1 −1 1 1 −1 −1 −1 1 1 −1 −1 −1 −1 −1 1 −1 1 −1 1 1 1 |
| | 1 −1 1 −1 1 1 1 −1 −1 −1 1 1 −1 −1 −1 1 1 1 −1 −1 1 −1 −1 1 1 1 −1 −1 1 −1 −1 |
| | 1 1 1 −1 −1 1 1 1 1 1 −1 1 −1 1 1 1 1 1 −1 1 −1 1 −1 −1 1 1 1 −1 1 1 1 1 −1 −1 |
| | −1 1 1 −1 1 1 1 1 −1 1 −1 1 −1 −1 −1 −1 1 −1 1 −1 −1 1 −1 1 1 1 1 1 −1 1 −1 1 1 |
| | 1 1 1 1 −1 −1 1 −1 −1 1 1 1 −1 −1 1 −1 −1 1 1 −1 1 −1 1 1 1 1 1 1 −1 1 −1 −1 −1 |
| | −1 −1 1 −1 −1 1 −1 −1 1 1 −1 1 1 −1 1 1 −1 −1 −1 1 1 −1 1 1 −1 −1 −1 1 1 −1 1 |
| | 1 −1 −1 1 −1 1 −1 −1 −1 −1 −1 1 −1 1 −1 −1 −1 −1 −1 −1 1 1 −1 1 1 −1 −1 1 −1 |
| | −1 1 −1 −1 1 1 1 −1 1 −1 −1 −1 −1 −1 −1 1 −1 1 1 1 1 1 −1 −1 −1 −1 −1 1 −1 1 |
| | −1 −1 −1 −1 −1 1 −1 1 −1 −1 1 1 −1 1 1 −1 −1 −1 1 1 −1 1 1 −1 1 1 1 1 1 −1 1 |
| | −1 −1 −1 −1 −1 −1 1 −1 1 1 1 −1 −1 1 −1 −1 1 −1 −1 1 1 −1 1 1 −1 −1 −1 1 1 −1 |
| | 1 1 −1 −1 −1 1 1 −1 1 1 −1 −1 −1 −1 −1 −1 1 −1 1 −1 −1 −1 −1 −1 1 −1 1 1 1 −1 |
| | −1 1 −1 −1 1 −1 −1 1 1 −1 1 1 −1 1 1 1 1 1 −1 1 −1 −1 −1 −1 −1 −1 1 −1 1 1 −1 |
| | 1 −1 1 1 1 1 1 −1 1 −1 1 1 1 1 1 −1 −1 1 1 1 −1 −1 1 −1 −1 1 1 1 −1 −1 −1 1 −1 1 |
| | −1 −1 −1 −1 1 −1 1 −1 1 1 1 1 −1 1 1 −1 −1 −1 1 1 1 −1 −1 1 1 1 −1 −1 1 −1 −1 |
| | 1 1 1 −1 −1 1 −1 −1 1 1 1 −1 −1 1 −1 1 −1 1 1 1 1 1 −1 1 −1 1 1 1 1 −1 1 1 −1 −1 |
| | −1 1 1 1 −1 −1 1 1 1 −1 −1 −1 1 −1 1 −1 −1 −1 −1 1 −1 1 −1 1 1 1 1 −1 −1 −1 −1 |
| | 1 −1 1 −1 −1 −1 −1 −1 1 −1 1 −1 1 1 −1 −1 −1 1 1 −1 1 1 −1 −1 −1 1 1 −1 1 1 1 |
| | 1 −1 1 −1 1 −1 −1 −1 −1 1 −1 1 −1 −1 −1 1 1 1 −1 −1 1 1 1 −1 −1 −1 1 1 −1 −1 |
| | −1 1 1 1 −1 −1 1 −1 −1 1 1 1 −1 −1 1 1 1 1 1 −1 1 −1 1 1 1 1 1 −1 1 −1 1 1 1 −1 |
| | −1 −1 1 1 −1 −1 −1 1 1 1 −1 −1 1 −1 −1 −1 −1 1 −1 1 −1 1 1 1 1 −1 1 −1 1 1 −1 |
| | 1 −1 −1 −1 −1 −1 1 −1 1 −1 −1 −1 −1 −1 −1 1 1 −1 1 1 −1 −1 −1 1 1 −1 1 1 −1 |
| | −1 −1 1 −1 1 1 1 1 1 1 −1 1 −1 −1 −1 −1 −1 1 −1 −1 1 −1 −1 1 1 −1 1 1 −1 1 1 |
| | −1 −1 1 −1 −1 1 −1 −1 1 1 1 −1 −1 1 −1 −1 1 1 −1 1 −1 1 1 1 1 1 −1 1 −1 1 1 1 1 |
| | 1 −1 1 1 −1 1 1 −1 −1 1 −1 −1 1 −1 −1 1 1 1 −1 1 −1 −1 −1 −1 −1 −1 1 −1 1 1 1 |
| | 1 1 −1 −1 −1 −1 −1 1 −1 1 1 1 1 1 1 −1 1 −1 −1 −1 1 1 −1 1 1 −1 1 1 −1 −1 1 −1 |
| | −1 1 −1 −1 −1 −1 −1 1 −1 1 −1 −1 −1 −1 −1 1 −1 1 −1 −1 1 1 −1 1 1 −1 −1 −1 1 |
| | 1 −1 1 1 −1 −1 −1 1 1 −1 1 1 −1 1 1 −1 −1 1 −1 −1 1 −1 −1 −1 −1 −1 1 −1 1 1 1 |
| | 1 1 1 −1 1 −1 −1 −1 1 1 −1 1 1 −1 −1 −1 1 1 −1 1 1 −1 −1 −1 −1 −1 −1 1 −1 1 −1 |
| | −1 −1 −1 −1 1 −1 1 −1 1 −1 1 −1 −1 −1 −1 1 −1 1 −1 1 1 1 1 −1 1 1 −1 −1 −1 1 1 |
| | 1 −1 −1 1 1 1 −1 −1 −1 1 −1 1 −1 −1 −1 −1 −1 1 −1 1 −1 −1 −1 −1 −1 1 1 −1 −1 |
| | −1 1 1 −1 1 1 −1 −1 −1 1 1 −1 1 1 −1 −1 −1 1 1 1 −1 −1 1 1 1 −1 −1 −1 1 −1 1 |
| | −1 −1 −1 −1 1 −1 1 −1 1 1 1 1 −1 1 1 −1 −1 −1 1 1 −1 1 1 −1 −1 −1 1 1 −1 1 −1 |
| | 1 −1 −1 −1 −1 −1 1 −1 1 −1 −1 −1 −1 −1 −1 −1 −1 1 −1 1 −1 1 1 1 1 −1 1 −1 1 1 |
| | 1 −1 −1 −1 1 1 −1 −1 −1 1 1 1 −1 −1 1 −1 −1 −1 −1 1 −1 1 −1 −1 −1 −1 −1 1 −1 |
| | 1 −1 1 1 −1 −1 −1 1 1 −1 1 1 −1 −1 −1 1 1 −1 −1 −1 1 1 1 −1 −1 1 1 1 −1 −1 −1 |
| | 1 1 −1 1 1 1 1 −1 1 −1 1 −1 −1 −1 −1 1 −1 1 −1 −1 −1 1 1 1 −1 −1 1 −1 −1 1 1 1 |
| | −1 −1 1 1 1 1 1 −1 1 −1 1 1 1 1 1 −1 1 −1 1 −1 1 −1 1 1 1 1 1 1 −1 1 −1 −1 −1 −1 |
| | −1 1 −1 −1 1 −1 −1 1 1 −1 1 1 −1 1 1 −1 −1 −1 1 −1 1 1 1 1 1 −1 1 −1 1 1 1 1 1 1 |
| | −1 −1 1 −1 −1 1 1 1 −1 −1 1 −1 −1 1 1 −1 1 1 −1 1 1 −1 −1 1 −1 −1 1 −1 −1 1 1 |
| | 1 −1 1 −1 −1 −1 −1 −1 −1 1 −1 1 1 1 1 1 −1 1 1 −1 1 1 −1 −1 −1 1 1 −1 1 1 −1 |
| | −1 1 −1 1 −1 −1 −1 −1 −1 1 −1 1 −1 −1 −1 −1 −1 −1 −1 −1 −1 −1 1 −1 1 1 1 1 1 |
| | 1 −1 1 −1 −1 −1 1 1 −1 1 1 −1 1 1 −1 −1 1 −1 −1 1 1 1 1 1 1 −1 1 −1 1 1 1 1 1 −1 |
| | 1 −1 1 1 −1 −1 1 −1 −1 1 1 1 −1 −1 1 −1 −1 1 −1 −1 1 1 −1 1 1 −1 1 1 −1 −1 1 |
| | −1 −1 1 −1 −1 −1 −1 −1 1 −1 1 1 1 1 1 1 −1 1 −1 1 1 −1 −1 1 −1 −1 1 1 1 −1 −1 |
| | 1 −1 −1 1 1 1 1 1 1 −1 1 −1 1 1 1 1 1 −1 1 −1 1 −1 1 −1 1 1 1 1 −1 1 −1 1 −1 −1 |
| | −1 −1 1 −1 −1 1 1 1 −1 −1 −1 1 1 −1 −1 −1 1 1 −1 1 −1 1 −1 −1 −1 −1 −1 1 −1 1 |
| | −1 −1 −1 −1 −1 1 1 −1 −1 −1 1 1 −1 1 1 −1 −1 −1 1 1 1 −1 −1 1 1 1 −1 −1 −1 1 1 |
| | −1 −1 −1 1 1 1 −1 1 −1 1 1 1 1 −1 1 −1 1 −1 −1 −1 −1 −1 1 1 −1 −1 −1 1 1 −1 1 |
| | 1 −1 −1 −1 1 1 −1 1 −1 1 −1 −1 −1 −1 −1 1 −1 1 −1 −1 −1 −1 −1 −1 −1 −1 1 −1 |
| | 1 −1 1 1 1 1 −1 1 −1 1 1 1 −1 −1 −1 1 1 −1 −1 −1 1 1 1 −1 −1 1 1 1 1 1 −1 1 −1 1 |
| | 1 1 1 1 −1 1 −1 1 −1 −1 1 1 1 −1 −1 1 −1 −1 1 1 1 −1 −1 1 −1 −1 1 1 1 −1 −1 1 1 |
| | 1 −1 −1 −1 1 1 −1 1 1 1 1 −1 1 −1 1 −1 −1 −1 −1 1 −1 1 −1 1 1 −1 −1 −1 1 1 −1 |
| | 1 1 −1 −1 −1 1 1 −1 −1 −1 −1 −1 1 −1 1 −1 −1 −1 −1 −1 1 −1 1 −1 1 −1 1 −1 −1 |
| | −1 −1 −1 −1 1 −1 1 1 1 1 1 −1 1 1 −1 1 1 −1 −1 1 −1 −1 1 −1 −1 1 1 −1 1 −1 1 1 |
| | 1 1 1 −1 1 −1 1 1 1 1 1 1 −1 −1 1 −1 −1 1 1 1 −1 −1 1 −1 −1 1 1 1 −1 −1 1 −1 −1 |
| | 1 1 −1 1 1 −1 1 1 −1 −1 −1 1 −1 1 1 1 1 1 1 −1 1 −1 −1 −1 −1 −1 −1 1 1 −1 1 1 |
| | −1 −1 −1 1 1 −1 1 1 −1 −1 1 −1 1 −1 −1 −1 −1 −1 1 −1 1 −1 −1 −1 −1 −1 1 1 1 1 |
| | 1 −1 1 −1 1 1 1 1 1 −1 1 −1 1 1 −1 −1 1 −1 −1 1 1 1 −1 −1 1 −1 −1 1 1 1 1 1 1 −1 |
| | 1 −1 −1 −1 −1 −1 −1 1 −1 1 1 1 −1 −1 1 −1 −1 1 −1 −1 1 1 −1 1 1 −1 1 1 −1 −1 1 |
| | −1 −1 1 1 1 −1 −1 1 −1 −1 1 1 1 1 1 1 −1 1 −1 1 1 1 1 1 −1 1 −1 1 1 −1 −1 1 −1 |
| | −1 1 −1 −1 1 1 −1 1 1 −1 1 1 1 1 1 −1 1 −1 −1 −1 −1 −1 −1 1 −1 1 1 −1 1 −1 1 1 |
| | 1 1 1 −1 1 −1 1 1 1 1 1 −1 −1 1 1 1 −1 −1 1 −1 −1 1 1 1 −1 −1 1 −1 1 −1 1 1 1 1 |
| | −1 1 −1 1 −1 −1 −1 −1 1 −1 −1 1 1 1 −1 −1 −1 1 1 −1 −1 −1 1 1 1 −1 −1 1 1 1 −1 |
| | −1 1 −1 −1 1 1 1 −1 −1 1 −1 1 −1 1 1 1 1 1 −1 1 −1 1 1 1 1 1 −1 −1 1 1 1 −1 −1 |
| | −1 1 1 −1 −1 −1 1 1 1 −1 1 −1 1 1 1 1 −1 1 −1 1 −1 −1 −1 −1 1 1 1 1 −1 1 −1 1 1 |
| | 1 1 1 −1 1 −1 1 −1 −1 1 1 1 −1 −1 1 −1 −1 1 1 1 −1 1 1 1 1 1 1 −1 1 −1 1 −1 −1 |
| | −1 −1 1 −1 1 −1 −1 −1 1 1 1 −1 −1 1 1 1 −1 −1 −1 1 1 −1 1 1 −1 −1 −1 1 1 −1 1 |
| | 1 −1 −1 −1 1 1 −1 −1 −1 −1 −1 1 −1 1 −1 −1 −1 −1 −1 1 −1 1 −1 1 1 −1 −1 −1 1 |
| | 1 −1 −1 −1 1 1 1 −1 −1 1 −1 −1 −1 −1 1 −1 1 −1 1 1 1 1 −1 1 −1 1 1 −1 1 −1 −1 |
| | −1 −1 −1 1 −1 1 −1 −1 −1 −1 −1 −1 1 1 −1 1 1 −1 −1 −1 1 1 −1 1 1 −1 −1 1 −1 1 |
| | −1 −1 −1 −1 −1 −1 1 −1 1 1 1 1 1 −1 1 1 −1 1 1 −1 −1 1 −1 −1 1 −1 −1 1 1 1 −1 |
| | −1 1 −1 −1 1 1 1 −1 −1 1 −1 −1 1 1 −1 1 −1 1 1 1 1 1 −1 1 −1 1 1 1 1 1 1 −1 −1 1 |
| | −1 −1 1 1 −1 1 1 −1 1 1 −1 −1 −1 1 −1 1 1 1 1 1 1 −1 1 −1 −1 −1 −1 −1 1 1 1 1 1 |
| | −1 1 −1 1 1 1 1 1 −1 1 −1 1 1 −1 −1 1 −1 −1 1 1 1 −1 −1 1 −1 −1 1 −1 −1 −1 −1 |
| | −1 1 −1 1 1 1 1 1 1 −1 1 −1 −1 −1 1 1 −1 1 1 −1 1 1 −1 −1 1 −1 −1 1 1 1 −1 −1 1 |
| | −1 −1 1 1 1 −1 −1 1 −1 −1 1 1 1 1 1 1 −1 1 −1 1 1 1 1 1 −1 1 −1 −1 −1 1 1 −1 1 1 |
| | −1 1 1 −1 −1 1 −1 −1 1 −1 −1 −1 −1 −1 1 −1 1 1 1 1 1 1 −1 1 −1 −1 1 −1 1 −1 −1 |
| | −1 −1 −1 1 −1 1 −1 −1 −1 −1 −1 1 1 −1 −1 −1 1 1 −1 1 1 −1 −1 −1 1 1 1 −1 1 −1 |
| | 1 1 1 1 −1 1 −1 1 −1 −1 −1 −1 1 −1 −1 1 1 1 −1 −1 −1 1 1 −1 −1 −1 1 1 −1 1 1 |
| | −1 −1 −1 1 1 −1 1 1 −1 −1 −1 1 1 −1 1 −1 1 −1 −1 −1 −1 −1 1 −1 1 −1 −1 −1 −1 |
| | 1 −1 −1 1 1 1 −1 −1 −1 1 1 −1 −1 −1 1 1 1 −1 1 −1 1 1 1 1 −1 1 −1 1 −1 −1 −1 |
| | −1 1 1 1 1 −1 1 −1 1 1 1 1 1 −1 1 −1 1 −1 −1 1 1 1 −1 −1 1 −1 −1 1 1 1 −1 −1 1 |
| | −1 −1 −1 −1 1 −1 1 −1 1 1 1 1 −1 1 −1 1 1 1 −1 −1 −1 1 1 −1 −1 −1 1 1 1 −1 −1 |
| | 1 1 1 −1 −1 −1 1 1 −1 1 1 −1 −1 −1 1 1 −1 −1 −1 −1 −1 1 −1 1 −1 −1 −1 −1 −1 1 |
| | −1 1 −1 −1 −1 1 1 1 −1 −1 1 1 1 −1 −1 −1 1 1 −1 1 1 1 1 −1 1 −1 1 −1 −1 −1 −1 |
| | 1 −1 1 −1 −1 1 −1 1 1 1 1 1 −1 1 −1 1 1 1 1 1 1 −1 −1 1 −1 −1 1 1 1 −1 −1 1 −1 |
| | −1 1 1 1 −1 1 −1 −1 −1 −1 −1 −1 1 −1 1 1 1 1 1 −1 1 1 −1 1 1 −1 −1 1 −1 −1 1 |
| | −1 −1 1 1 −1 1 1 −1 1 1 −1 −1 −1 1 1 −1 1 1 −1 −1 1 −1 1 −1 −1 −1 −1 −1 1 −1 1 |
| | −1 −1 −1 −1 −1 1 −1 −1 1 −1 −1 1 1 −1 1 1 −1 1 1 −1 −1 −1 1 −1 1 1 1 1 1 1 −1 |
| | 1 −1 −1 −1 −1 −1 −1 −1 −1 −1 −1 1 −1 1 1 1 1 1 1 −1 1 −1 −1 −1 1 1 −1 1 1 −1 1 |
| | 1 −1 −1 1 −1 −1 1 −1 −1 −1 −1 −1 1 −1 1 −1 −1 −1 −1 −1 1 −1 1 −1 −1 1 1 −1 1 |
| | 1 −1 −1 −1 1 1 −1 1 1 −1 −1 −1 1 1 −1 1 1 −1 1 1 −1 −1 1 −1 −1 1 −1 −1 −1 −1 |
| | −1 1 −1 1 1 1 1 1 1 −1 1 −1 −1 −1 1 1 −1 1 1 −1 −1 −1 1 1 −1 1 1 −1 −1 −1 −1 |
| | −1 −1 1 −1 1 −1 −1 −1 −1 −1 1 −1 1 −1 1 −1 1 −1 −1 −1 −1 1 −1 1 −1 1 1 1 1 −1 |
| | 1 1 −1 −1 −1 1 1 1 −1 −1 1 1 1 −1 −1 −1 1 −1 1 −1 −1 −1 −1 −1 1 −1 1 −1 −1 −1 |
| | −1 −1 1 1 −1 −1 −1 1 1 −1 1 1 −1 −1 −1 1 1 −1 1 1 −1 −1 −1 1 1 1 −1 −1 1 1 1 |
| | −1 −1 −1 1 −1 1 −1 −1 −1 −1 1 −1 1 −1 1 1 1 1 −1 1 1 −1 −1 −1 1 1 −1 1 1 −1 −1 |
| | −1 1 1 −1 1 −1 1 −1 −1 −1 −1 −1 1 −1 1 −1 −1 −1 −1 −1 −1 −1 −1 1 −1 1 −1 1 1 |
| | 1 1 −1 1 −1 1 1 1 −1 −1 −1 1 1 −1 −1 −1 1 1 1 −1 −1 1 −1 −1 −1 −1 1 −1 1 −1 −1 |
| | −1 −1 −1 1 −1 1 −1 1 1 −1 −1 −1 1 1 −1 1 1 −1 −1 −1 1 1 −1 −1 −1 1 1 1 −1 −1 1 |
| | 1 1 −1 −1 −1 1 1 −1 1 1 1 1 −1 1 −1 1 −1 −1 −1 −1 1 −1 1 −1 −1 −1 1 1 1 −1 −1 |
| | 1 −1 −1 1 1 1 −1 −1 1 1 1 1 1 −1 1 −1 1 1 1 1 1 −1 1 −1 1 −1 1 −1 1 1 1 1 1 1 −1 |
| | 1 −1 −1 −1 −1 −1 1 −1 −1 1 −1 −1 1 1 −1 1 1 −1 1 1 −1 −1 −1 1 −1 1 1 1 1 1 −1 |
| | 1 −1 1 1 1 1 1 1 −1 −1 1 −1 −1 1 1 1 −1 −1 1 −1 −1 1 1 −1 1 1 −1 1 1 −1 −1 1 −1 |
| | −1 1 −1 −1 1 1 1 −1 1 −1 −1 −1 −1 −1 −1 1 −1 1 1 1 1 1 −1 1 1 −1 1 1 −1 −1 −1 |
| | 1 1 −1 1 1 −1 −1 1 −1 1 −1 −1 −1 −1 −1 1 −1 1 −1 −1 −1 −1 −1 −1 −1 −1 −1 −1 |
| | 1 −1 1 1 1 1 1 1 −1 1 −1 −1 −1 1 1 −1 1 1 −1 1 1 −1 −1 1 −1 −1 1 1 1 1 1 1 −1 1 |
| | −1 1 1 1 1 1 −1 1 −1 1 1 −1 −1 1 −1 −1 1 1 1 −1 −1 1 −1 −1 1 −1 −1 1 1 −1 1 1 |
| | −1 1 1 −1 −1 1 −1 −1 1 −1 −1 −1 −1 −1 1 −1 1 1 1 1 1 1 −1 1 −1 1 1 −1 −1 1 −1 |
| | −1 1 1 1 −1 −1 1 −1 −1 1 1 1 1 1 1 −1 1 −1 1 1 1 1 1 −1 1 −1 1 −1 1 −1 1 1 1 1 |
| | −1 1 −1 1 −1 −1 −1 −1 1 −1 −1 1 1 1 −1 −1 −1 1 1 −1 −1 −1 1 1 −1 1 −1 1 −1 −1 |
| | −1 −1 −1 1 −1 1 −1 −1 −1 −1 −1 1 1 −1 −1 −1 1 1 −1 1 1 −1 −1 −1 1 1 1 −1 −1 1 |
| | 1 1 −1 −1 −1 1 1 −1 −1 −1 1 1 1 −1 1 −1 1 1 1 1 −1 1 −1 1 −1 −1 −1 −1 −1 1 1 |
| | −1 −1 −1 1 1 −1 1 1 −1 −1 −1 1 1 −1 1 −1 1 −1 −1 −1 −1 −1 1 −1 1 −1 −1 −1 −1 |
| | −1 −1 −1 −1 1 −1 1 −1 1 1 1 1 −1 1 −1 1 1 1 −1 −1 −1 1 1 −1 −1 −1 1 1 1 −1 −1 |
| | 1 1 1 1 1 −1 1 −1 1 1 1 1 1 −1 1 −1 1 −1 −1 1 1 1 −1 −1 1 −1 −1 1 1 1 −1 −1 1 −1 |
| | −1 1 1 1 −1 −1 1 1 1 −1 −1 −1 1 1 −1 1 1 1 1 −1 1 −1 1 −1 −1 −1 −1 1 −1 1 −1 1 |
| | 1 −1 −1 −1 1 1 −1 1 1 −1 −1 −1 1 1 −1 −1 −1 −1 −1 1 −1 1 −1 −1 −1 −1 −1 1 −1 |
| | 1 −1 1 −1 1 −1 −1 −1 −1 −1 −1 1 −1 1 1 1 1 1 −1 1 1 −1 1 1 −1 −1 1 −1 −1 1 −1 |
| | −1 1 1 −1 1 −1 1 1 1 1 1 −1 1 −1 1 1 1 1 1 1 −1 −1 1 −1 −1 1 1 1 −1 −1 1 −1 −1 1 |
| | 1 1 −1 −1 1 −1 −1 1 1 −1 1 1 −1 1 1 −1 −1 −1 1 −1 1 1 1 1 1 −1 1 −1 −1 −1 −1 |
| | −1 −1 1 1 −1 1 1 −1 −1 −1 1 1 −1 1 1 −1 −1 1 −1 1 −1 −1 −1 −1 −1 1 −1 1 −1 −1 |
| | −1 −1 −1 |
| 5 | 1 1 1 1 1 1 −1 −1 1 1 −1 −1 1 1 1 1 1 1 1 1 1 1 −1 −1 −1 −1 1 1 −1 −1 −1 −1 1 −1 |
| | 1 −1 −1 1 1 −1 1 −1 −1 1 −1 1 −1 1 1 −1 1 −1 −1 1 1 −1 −1 1 1 −1 1 −1 1 −1 1 1 |
| | 1 1 1 1 −1 −1 1 1 −1 −1 1 1 1 1 1 1 1 1 1 1 −1 −1 −1 −1 1 1 −1 −1 −1 −1 1 −1 1 |
| | −1 −1 1 1 −1 1 −1 −1 1 −1 1 −1 1 1 −1 1 −1 −1 1 1 −1 −1 1 1 −1 1 −1 1 −1 1 1 1 |
| | 1 1 1 −1 −1 1 1 −1 −1 1 1 1 1 −1 −1 −1 −1 −1 −1 1 1 1 1 −1 −1 1 1 1 1 1 −1 1 −1 |
| | −1 1 1 −1 1 −1 −1 1 −1 1 −1 1 −1 1 −1 1 1 −1 −1 1 1 −1 −1 1 −1 1 −1 1 −1 −1 −1 |
| | −1 −1 −1 1 1 −1 −1 1 1 −1 −1 −1 −1 1 1 1 1 1 1 −1 −1 −1 −1 1 1 −1 −1 −1 −1 −1 |
| | 1 −1 1 1 −1 −1 1 −1 1 1 −1 1 −1 1 −1 1 −1 1 −1 −1 1 1 −1 −1 1 1 −1 1 −1 1 −1 1 |
| | 1 1 1 1 1 −1 −1 1 1 −1 −1 1 1 1 1 1 1 1 1 1 1 −1 −1 −1 −1 1 1 −1 −1 −1 −1 1 −1 1 |
| | −1 −1 1 1 −1 1 −1 −1 1 −1 1 −1 1 1 −1 1 −1 −1 1 1 −1 −1 1 1 −1 1 −1 1 −1 −1 −1 |
| | −1 −1 −1 −1 1 1 −1 −1 1 1 −1 −1 −1 −1 −1 −1 −1 −1 −1 −1 1 1 1 1 −1 −1 1 1 1 1 |
| | −1 1 −1 1 1 −1 −1 1 −1 1 1 −1 1 −1 1 −1 −1 1 −1 1 1 −1 −1 1 1 −1 −1 1 −1 1 −1 |
| | 1 1 1 1 1 1 1 −1 −1 1 1 −1 −1 1 1 1 1 −1 −1 −1 −1 −1 −1 1 1 1 1 −1 −1 1 1 1 1 1 |
| | −1 1 −1 −1 1 1 −1 1 −1 −1 1 −1 1 −1 1 −1 1 −1 1 1 −1 −1 1 1 −1 −1 1 −1 1 −1 1 |
| | 1 1 1 1 1 1 −1 −1 1 1 −1 −1 1 1 1 1 −1 −1 −1 −1 −1 −1 1 1 1 1 −1 −1 1 1 1 1 1 −1 |
| | 1 −1 −1 1 1 −1 1 −1 −1 1 −1 1 −1 1 −1 1 −1 1 1 −1 −1 1 1 −1 −1 1 −1 1 −1 1 1 1 |
| | 1 1 1 1 −1 −1 1 1 −1 −1 1 1 1 1 1 1 1 1 1 1 −1 −1 −1 −1 1 1 −1 −1 −1 −1 1 −1 1 |
| | −1 −1 1 1 −1 1 −1 −1 1 −1 1 −1 1 1 −1 1 −1 −1 1 1 −1 −1 1 1 −1 1 −1 1 −1 1 1 1 |
| | 1 1 1 −1 −1 1 1 −1 −1 1 1 1 1 1 1 1 1 1 1 −1 −1 −1 −1 1 1 −1 −1 −1 −1 1 −1 1 −1 |
| | −1 1 1 −1 1 −1 −1 1 −1 1 −1 1 1 −1 1 −1 −1 1 1 −1 −1 1 1 −1 1 −1 1 −1 1 1 1 1 1 |
| | 1 −1 −1 1 1 −1 −1 1 1 1 1 −1 −1 −1 −1 −1 −1 1 1 1 1 −1 −1 1 1 1 1 1 −1 1 −1 −1 |
| | 1 1 −1 1 −1 −1 1 −1 1 −1 1 −1 1 −1 1 1 −1 −1 1 1 −1 −1 1 −1 1 −1 1 −1 −1 −1 −1 |
| | −1 −1 1 1 −1 −1 1 1 −1 −1 −1 −1 1 1 1 1 1 1 −1 −1 −1 −1 1 1 −1 −1 −1 −1 −1 1 |
| | −1 1 1 −1 −1 1 −1 1 1 −1 1 −1 1 −1 1 −1 1 −1 −1 1 1 −1 −1 1 1 −1 1 −1 1 −1 1 1 |
| | 1 1 1 1 −1 −1 1 1 −1 −1 1 1 1 1 1 1 1 1 1 1 −1 −1 −1 −1 1 1 −1 −1 −1 −1 1 −1 1 |
| | −1 −1 1 1 −1 1 −1 −1 1 −1 1 −1 1 1 −1 1 −1 −1 1 1 −1 −1 1 1 −1 1 −1 1 −1 −1 −1 |
| | −1 −1 −1 −1 1 1 −1 −1 1 1 −1 −1 −1 −1 −1 −1 −1 −1 −1 −1 1 1 1 1 −1 −1 1 1 1 1 |
| | −1 1 −1 1 1 −1 −1 1 −1 1 1 −1 1 −1 1 −1 −1 1 −1 1 1 −1 −1 1 1 −1 −1 1 −1 1 −1 |
| | 1 1 1 1 1 1 1 −1 −1 1 1 −1 −1 1 1 1 1 −1 −1 −1 −1 −1 −1 1 1 1 1 −1 −1 1 1 1 1 1 |
| | −1 1 −1 −1 1 1 −1 1 −1 −1 1 −1 1 −1 1 −1 1 −1 1 1 −1 −1 1 1 −1 −1 1 −1 1 −1 1 |
| | 1 1 1 1 1 1 −1 −1 1 1 −1 −1 1 1 1 1 −1 −1 −1 −1 −1 −1 1 1 1 1 −1 −1 1 1 1 1 1 −1 |
| | 1 −1 −1 1 1 −1 1 −1 −1 1 −1 1 −1 1 −1 1 −1 1 1 −1 −1 1 1 −1 −1 1 1 1 −1 1 1 1 |
| | 1 1 1 1 −1 −1 1 1 −1 −1 1 1 1 1 1 1 1 1 1 1 −1 −1 −1 −1 1 1 −1 −1 −1 −1 1 −1 1 |
| | −1 −1 1 1 −1 1 −1 −1 1 −1 1 −1 1 1 −1 1 −1 −1 1 1 −1 −1 1 1 −1 1 −1 1 −1 1 1 1 |
| | 1 1 1 −1 −1 1 1 −1 −1 1 1 1 1 1 1 1 1 1 1 −1 −1 −1 −1 1 1 −1 −1 −1 −1 1 −1 1 −1 |
| | −1 1 1 −1 1 −1 −1 1 −1 1 −1 1 1 −1 1 −1 −1 1 1 −1 −1 1 1 −1 1 −1 1 −1 1 1 1 1 1 |
| | 1 −1 −1 1 1 −1 −1 1 1 1 1 −1 −1 −1 −1 −1 −1 1 1 1 1 −1 −1 1 1 1 1 1 −1 1 −1 −1 |
| | 1 1 −1 1 −1 −1 1 −1 1 −1 1 −1 1 −1 1 1 −1 −1 1 1 −1 −1 1 −1 1 −1 1 −1 −1 −1 −1 |
| | −1 −1 1 1 −1 −1 1 1 −1 −1 −1 −1 1 1 1 1 1 1 −1 −1 −1 −1 1 1 −1 −1 −1 −1 −1 1 |
| | −1 1 1 −1 −1 1 −1 1 1 −1 1 −1 1 −1 1 −1 1 −1 −1 1 1 −1 −1 1 1 −1 1 −1 1 −1 −1 |
| | −1 −1 −1 −1 −1 1 1 −1 −1 1 1 −1 −1 −1 −1 −1 −1 −1 −1 −1 −1 1 1 1 1 −1 −1 1 1 |
| | 1 1 −1 1 −1 1 1 −1 −1 1 −1 1 1 −1 1 −1 1 −1 −1 1 −1 1 1 −1 −1 1 1 −1 −1 1 −1 1 |
| | −1 1 1 1 1 1 1 1 −1 −1 1 1 −1 −1 1 1 1 1 1 1 1 1 1 1 −1 −1 −1 −1 1 1 −1 −1 −1 −1 |
| | 1 −1 1 −1 −1 1 1 −1 1 −1 −1 1 −1 1 −1 1 1 −1 1 −1 −1 1 1 −1 −1 1 1 −1 1 −1 1 |
| | −1 −1 −1 −1 −1 −1 −1 1 1 −1 −1 1 1 −1 −1 −1 −1 1 1 1 1 1 1 −1 −1 −1 −1 1 1 −1 |
| | −1 −1 −1 −1 1 −1 1 1 −1 −1 1 −1 1 1 −1 1 −1 1 −1 1 −1 1 −1 −1 1 1 −1 −1 1 1 −1 |
| | 1 −1 1 −1 −1 −1 −1 −1 −1 −1 1 1 −1 −1 1 1 −1 −1 −1 −1 1 1 1 1 1 1 −1 −1 −1 −1 |
| | 1 1 −1 −1 −1 −1 −1 1 −1 1 1 −1 −1 1 −1 1 1 −1 1 −1 1 −1 1 −1 1 −1 −1 1 1 −1 −1 |
| | 1 1 −1 1 −1 1 −1 −1 −1 −1 −1 −1 −1 1 1 −1 −1 1 1 −1 −1 −1 −1 −1 −1 −1 −1 −1 |
| | −1 1 1 1 1 −1 −1 1 1 1 1 −1 1 −1 1 1 −1 −1 1 −1 1 1 −1 1 −1 1 −1 −1 1 −1 1 1 −1 |
| | −1 1 1 −1 −1 1 −1 1 −1 1 −1 −1 −1 −1 −1 −1 1 1 −1 −1 1 1 −1 −1 −1 −1 −1 −1 |
| | −1 −1 −1 −1 1 1 1 1 −1 −1 1 1 1 1 −1 1 −1 1 1 −1 −1 1 −1 1 1 −1 1 −1 1 −1 −1 1 |
| | −1 1 1 −1 −1 1 1 −1 −1 1 −1 1 −1 1 −1 −1 −1 −1 −1 −1 1 1 −1 −1 1 1 −1 −1 −1 |
| | −1 1 1 1 1 1 1 −1 −1 −1 −1 1 1 −1 −1 −1 −1 −1 1 −1 1 1 −1 −1 1 −1 1 1 −1 1 −1 |
| | 1 −1 1 −1 1 −1 −1 1 1 −1 −1 1 1 −1 1 −1 1 −1 1 1 1 1 1 1 −1 −1 1 1 −1 −1 1 1 1 1 |
| | −1 −1 −1 −1 −1 −1 1 1 1 1 −1 −1 1 1 1 1 1 −1 1 −1 −1 1 1 −1 1 −1 1 1 −1 1 −1 |
| | 1 −1 1 −1 1 1 −1 −1 1 1 −1 −1 1 −1 1 −1 1 1 1 1 1 1 1 −1 −1 1 1 −1 −1 1 1 1 1 1 |
| | 1 1 1 1 1 −1 −1 −1 −1 1 1 −1 −1 −1 −1 1 −1 1 −1 −1 1 1 −1 1 −1 −1 1 −1 1 −1 1 |
| | 1 −1 1 −1 −1 1 1 −1 −1 1 1 −1 1 −1 1 −1 −1 −1 −1 −1 −1 −1 1 1 −1 −1 1 1 −1 −1 |
| | −1 −1 −1 −1 −1 −1 −1 −1 1 1 1 1 −1 −1 1 1 1 1 −1 1 −1 1 1 −1 −1 1 −1 1 1 −1 1 |
| | −1 1 −1 −1 1 −1 1 1 −1 −1 1 1 −1 −1 1 −1 1 −1 1 1 1 1 1 1 1 −1 −1 1 1 −1 −1 1 1 |
| | 1 1 −1 −1 −1 −1 −1 −1 1 1 1 1 −1 −1 1 1 1 1 1 −1 1 −1 −1 1 1 −1 1 −1 −1 1 −1 1 |
| | −1 1 −1 1 −1 1 1 −1 −1 1 1 −1 −1 1 −1 1 −1 1 1 1 1 1 1 1 −1 −1 1 1 −1 −1 1 1 1 1 |
| | −1 −1 −1 −1 −1 −1 1 1 1 1 −1 −1 1 1 1 1 1 −1 1 −1 −1 1 1 −1 1 −1 −1 1 −1 1 −1 |
| | 1 −1 1 −1 1 1 −1 −1 1 1 −1 −1 1 −1 1 −1 1 1 1 1 1 1 1 −1 −1 1 1 −1 −1 1 1 1 1 1 |
| | 1 1 1 1 1 −1 −1 −1 −1 1 1 −1 −1 −1 −1 1 −1 1 −1 −1 1 1 −1 1 −1 −1 1 −1 1 −1 1 |
| | 1 −1 1 −1 −1 1 1 −1 −1 1 1 −1 1 −1 1 −1 1 1 1 1 1 1 −1 −1 1 1 −1 −1 1 1 1 1 1 1 |
| | 1 1 1 1 −1 −1 −1 −1 1 1 −1 −1 −1 −1 1 −1 1 −1 −1 1 1 −1 1 −1 −1 1 −1 1 −1 1 1 |
| | −1 1 −1 −1 1 1 −1 −1 1 1 −1 1 −1 1 −1 1 1 1 1 1 1 −1 −1 1 1 −1 −1 1 1 1 1 −1 −1 |
| | −1 −1 −1 −1 1 1 1 1 −1 −1 1 1 1 1 1 −1 1 −1 −1 1 1 −1 1 −1 −1 1 −1 1 −1 1 −1 1 |
| | −1 1 1 −1 −1 1 1 −1 −1 1 −1 1 −1 1 −1 −1 −1 −1 −1 −1 1 1 −1 −1 1 1 −1 −1 −1 |
| | −1 1 1 1 1 1 1 −1 −1 −1 −1 1 1 −1 −1 −1 −1 −1 1 −1 1 1 −1 −1 1 −1 1 1 −1 1 −1 |
| | 1 −1 1 −1 1 −1 −1 1 1 −1 −1 1 1 −1 1 −1 1 −1 1 1 1 1 1 1 −1 −1 1 1 −1 −1 1 1 1 1 |
| | 1 1 1 1 1 1 −1 −1 −1 −1 1 1 −1 −1 −1 −1 1 −1 1 −1 −1 1 1 −1 1 −1 −1 1 −1 1 −1 |
| | 1 1 −1 1 −1 −1 1 1 −1 −1 1 1 −1 1 −1 1 −1 −1 −1 −1 −1 −1 −1 1 1 −1 −1 1 1 −1 |
| | −1 −1 −1 −1 −1 −1 −1 −1 −1 1 1 1 1 −1 −1 1 1 1 1 −1 1 −1 1 1 −1 −1 1 −1 1 1 −1 |
| | 1 −1 1 −1 −1 1 −1 1 1 −1 −1 1 1 −1 −1 1 −1 1 −1 1 1 1 1 1 1 1 −1 −1 1 1 −1 −1 1 |
| | 1 1 1 −1 −1 −1 −1 −1 −1 1 1 1 1 −1 −1 1 1 1 1 1 −1 1 −1 −1 1 1 −1 1 −1 −1 1 −1 |
| | 1 −1 1 −1 1 −1 1 1 −1 −1 1 1 −1 −1 1 −1 1 −1 1 1 1 1 1 1 1 −1 −1 1 1 −1 −1 1 1 1 |
| | 1 −1 −1 −1 −1 −1 −1 1 1 1 1 −1 −1 1 1 1 1 1 −1 1 −1 −1 1 1 −1 1 −1 −1 1 −1 1 |
| | −1 1 −1 1 −1 1 1 −1 −1 1 1 −1 −1 1 −1 1 −1 1 −1 −1 −1 −1 −1 −1 1 1 −1 −1 1 1 |
| | −1 −1 −1 −1 −1 −1 −1 −1 −1 −1 1 1 1 1 −1 −1 1 1 1 1 −1 1 −1 1 1 −1 −1 1 −1 1 1 |
| | −1 1 −1 1 −1 −1 1 −1 1 1 −1 −1 1 1 −1 −1 1 −1 1 −1 1 −1 −1 −1 −1 −1 −1 1 1 −1 |
| | −1 1 1 −1 −1 −1 −1 −1 −1 −1 −1 −1 −1 1 1 1 1 −1 −1 1 1 1 1 −1 1 −1 1 1 −1 −1 1 |
| | −1 1 1 −1 1 −1 1 −1 −1 1 −1 1 1 −1 −1 1 1 −1 −1 1 −1 1 −1 1 −1 −1 −1 −1 −1 −1 |
| | 1 1 −1 −1 1 1 −1 −1 −1 −1 1 1 1 1 1 1 −1 −1 −1 −1 1 1 −1 −1 −1 −1 −1 1 −1 1 1 |
| | −1 −1 1 −1 1 1 −1 1 −1 1 −1 1 −1 1 −1 −1 1 1 −1 −1 1 1 −1 1 −1 1 −1 1 1 1 1 1 |
| | −1 −1 1 1 −1 −1 1 1 1 1 −1 −1 −1 −1 −1 −1 1 1 1 1 −1 −1 1 1 1 1 1 −1 1 −1 −1 1 |
| | 1 −1 1 −1 −1 1 −1 1 −1 1 −1 1 −1 1 1 −1 −1 1 1 −1 −1 1 −1 1 −1 1 −1 −1 −1 −1 |
| | −1 −1 1 1 −1 −1 1 1 −1 −1 −1 −1 −1 −1 −1 −1 −1 −1 1 1 1 1 −1 −1 1 1 1 1 −1 1 |
| | −1 1 1 −1 −1 1 −1 1 1 −1 1 −1 1 −1 −1 1 −1 1 1 −1 −1 1 1 −1 −1 1 −1 1 −1 1 1 1 |
| | 1 1 1 1 −1 −1 1 1 −1 −1 1 1 1 1 1 1 1 1 1 1 −1 −1 −1 −1 1 1 −1 −1 −1 −1 1 −1 1 |
| | −1 −1 1 1 −1 1 −1 −1 1 −1 1 −1 1 1 −1 1 −1 −1 1 1 −1 −1 1 1 −1 1 −1 1 −1 −1 −1 |
| | −1 −1 −1 −1 1 1 −1 −1 1 1 −1 −1 −1 −1 1 1 1 1 1 1 −1 −1 −1 −1 1 1 −1 −1 −1 −1 |
| | −1 1 −1 1 1 −1 −1 1 −1 1 1 −1 1 −1 1 −1 1 −1 1 −1 −1 1 1 −1 −1 1 1 −1 1 −1 1 |
| | −1 −1 −1 −1 −1 −1 −1 1 1 −1 −1 1 1 −1 −1 −1 −1 1 1 1 1 1 1 −1 −1 −1 −1 1 1 −1 |
| | −1 −1 −1 −1 1 −1 1 1 −1 −1 1 −1 1 1 −1 1 −1 1 −1 1 −1 1 −1 −1 1 1 −1 −1 1 1 −1 |
| | 1 −1 1 −1 1 1 1 1 1 1 −1 −1 1 1 −1 −1 1 1 1 1 1 1 1 1 1 1 −1 −1 −1 −1 1 1 −1 −1 |
| | −1 −1 1 −1 1 −1 −1 1 1 −1 1 −1 −1 1 −1 1 −1 1 1 −1 1 −1 −1 1 1 −1 −1 1 1 −1 1 |
| | −1 1 −1 1 1 1 1 1 1 −1 −1 1 1 −1 −1 1 1 1 1 1 1 1 1 1 1 −1 −1 −1 −1 1 1 −1 −1 −1 |
| | −1 1 −1 1 −1 −1 1 1 −1 1 −1 −1 1 −1 1 −1 1 1 −1 1 −1 −1 1 1 −1 −1 1 1 −1 1 −1 |
| | 1 −1 1 1 1 1 1 1 −1 −1 1 1 −1 −1 1 1 1 1 −1 −1 −1 −1 −1 −1 1 1 1 1 −1 −1 1 1 1 1 |
| | 1 −1 1 −1 −1 1 1 −1 1 −1 −1 1 −1 1 −1 1 −1 1 −1 1 1 −1 −1 1 1 −1 −1 1 −1 1 −1 |
| | 1 −1 −1 −1 −1 −1 −1 1 1 −1 −1 1 1 −1 −1 −1 −1 1 1 1 1 1 1 −1 −1 −1 −1 1 1 −1 |
| | −1 −1 −1 −1 1 −1 1 1 −1 −1 1 −1 1 1 −1 1 −1 1 −1 1 −1 1 −1 −1 1 1 −1 −1 1 1 −1 |
| | 1 −1 1 −1 −1 −1 −1 −1 −1 −1 1 1 −1 −1 1 1 −1 −1 −1 −1 −1 −1 −1 −1 −1 −1 1 1 |
| | 1 1 −1 −1 1 1 1 1 −1 1 −1 1 1 −1 −1 1 −1 1 1 −1 1 −1 1 −1 −1 1 −1 1 1 −1 −1 1 1 |
| | −1 −1 1 −1 1 −1 1 1 1 1 1 1 1 −1 −1 1 1 −1 −1 1 1 1 1 1 1 1 1 1 1 −1 −1 −1 −1 1 |
| | 1 −1 −1 −1 −1 1 −1 1 −1 −1 1 1 −1 1 −1 −1 1 −1 1 −1 1 1 −1 1 −1 −1 1 1 −1 −1 1 |
| | 1 −1 1 −1 1 −1 −1 −1 −1 −1 −1 −1 1 1 −1 −1 1 1 −1 −1 −1 −1 1 1 1 1 1 1 −1 −1 |
| | −1 −1 1 1 −1 −1 −1 −1 −1 1 −1 1 1 −1 −1 1 −1 1 1 −1 1 −1 1 −1 1 −1 1 −1 −1 1 1 |
| | −1 −1 1 1 −1 1 −1 1 −1 −1 −1 −1 −1 −1 −1 1 1 −1 −1 1 1 −1 −1 −1 −1 1 1 1 1 1 1 |
| | −1 −1 −1 −1 1 1 −1 −1 −1 −1 −1 1 −1 1 1 −1 −1 1 −1 1 1 −1 1 −1 1 −1 1 −1 1 −1 |
| | −1 1 1 −1 −1 1 1 −1 1 −1 1 −1 1 1 1 1 1 1 −1 −1 1 1 −1 −1 1 1 1 1 1 1 1 1 1 1 −1 |
| | −1 −1 −1 1 1 −1 −1 −1 −1 1 −1 1 −1 −1 1 1 −1 1 −1 −1 1 −1 1 −1 1 1 −1 1 −1 −1 |
| | 1 1 −1 −1 1 1 −1 1 −1 1 −1 1 1 1 1 1 1 −1 −1 1 1 −1 −1 1 1 1 1 1 1 1 1 1 1 −1 −1 |
| | −1 −1 1 1 −1 −1 −1 −1 1 −1 1 −1 −1 1 1 −1 1 −1 −1 1 −1 1 −1 1 1 −1 1 −1 −1 1 1 |
| | −1 −1 1 1 −1 1 −1 1 −1 1 1 1 1 1 1 −1 −1 1 1 −1 −1 1 1 1 1 −1 −1 −1 −1 −1 −1 1 |
| | 1 1 1 −1 −1 1 1 1 1 1 −1 1 −1 −1 1 1 −1 1 −1 −1 1 −1 1 −1 1 −1 1 −1 1 1 −1 −1 1 |
| | 1 −1 −1 1 −1 1 −1 1 −1 −1 −1 −1 1 1 −1 −1 1 1 −1 −1 −1 −1 1 1 1 1 1 1 −1 |
| | −1 −1 −1 1 1 −1 −1 −1 −1 −1 1 −1 1 1 −1 −1 1 −1 1 1 −1 1 −1 1 −1 1 −1 1 −1 −1 |
| | 1 1 −1 −1 1 1 −1 1 −1 1 −1 −1 −1 −1 −1 −1 −1 1 1 −1 −1 1 1 −1 −1 −1 −1 −1 −1 |
| | −1 −1 −1 −1 1 1 1 1 −1 −1 1 1 1 1 −1 1 −1 1 1 −1 −1 1 −1 1 1 −1 1 −1 1 −1 −1 1 |
| | −1 1 1 −1 −1 1 1 −1 −1 1 −1 1 −1 1 1 1 1 1 1 1 −1 −1 1 1 −1 −1 1 1 1 1 1 1 1 1 1 |
| | 1 −1 −1 −1 −1 1 1 −1 −1 −1 −1 1 −1 1 −1 −1 1 1 −1 1 −1 −1 1 −1 1 −1 1 1 −1 1 |
| | −1 −1 1 1 −1 −1 1 1 −1 1 −1 1 −1 −1 −1 −1 −1 −1 −1 1 1 −1 −1 1 1 −1 −1 −1 −1 |
| | 1 1 1 1 1 1 −1 −1 −1 −1 1 1 −1 −1 −1 −1 −1 1 −1 1 1 −1 −1 1 −1 1 1 −1 1 −1 1 |
| | −1 1 −1 1 −1 −1 1 1 −1 −1 1 1 −1 1 −1 1 −1 −1 −1 −1 −1 −1 −1 1 1 −1 −1 1 1 −1 |
| | −1 −1 −1 1 1 1 1 1 1 −1 −1 −1 −1 1 1 −1 −1 −1 −1 −1 1 −1 1 1 −1 −1 1 −1 1 1 −1 |
| | 1 −1 1 −1 1 −1 1 −1 −1 1 1 −1 −1 1 1 −1 1 −1 1 −1 −1 −1 −1 −1 −1 −1 1 1 −1 −1 |
| | 1 1 −1 −1 −1 −1 −1 −1 −1 −1 −1 −1 1 1 1 1 −1 −1 1 1 1 1 −1 1 −1 1 1 −1 −1 1 −1 |
| | 1 1 −1 1 −1 1 −1 −1 1 −1 1 1 −1 −1 1 1 −1 −1 1 −1 1 −1 1 −1 −1 −1 −1 −1 −1 1 1 |
| | −1 −1 1 1 −1 −1 −1 −1 −1 −1 −1 −1 −1 −1 1 1 1 1 −1 −1 1 1 1 1 −1 1 −1 1 1 −1 |
| | −1 1 −1 1 1 −1 1 −1 1 −1 −1 1 −1 1 1 −1 −1 1 1 −1 −1 1 −1 1 −1 1 −1 −1 −1 −1 |
| | −1 −1 1 1 −1 −1 1 1 −1 −1 −1 −1 1 1 1 1 1 1 −1 −1 −1 −1 1 1 −1 −1 −1 −1 −1 1 |
| | −1 1 1 −1 −1 1 −1 1 1 −1 1 −1 1 −1 1 −1 1 −1 −1 1 1 −1 −1 1 1 −1 1 −1 1 −1 1 1 |
| | 1 1 1 1 −1 −1 1 1 −1 −1 1 1 1 1 −1 −1 −1 −1 −1 −1 1 1 1 1 −1 −1 1 1 1 1 1 −1 1 |
| | −1 −1 1 1 −1 1 −1 −1 1 −1 1 −1 1 −1 1 −1 1 1 −1 −1 1 1 −1 −1 1 −1 1 −1 1 −1 −1 |
| | −1 −1 −1 −1 1 1 −1 −1 1 1 −1 −1 −1 −1 −1 −1 −1 −1 −1 −1 1 1 1 1 −1 −1 1 1 1 1 |
| | −1 1 −1 1 1 −1 −1 1 −1 1 1 −1 1 −1 1 −1 −1 1 −1 1 1 −1 −1 1 1 −1 −1 1 −1 1 −1 |
| | 1 1 1 1 1 1 1 −1 −1 1 1 −1 −1 1 1 1 1 1 1 1 1 1 1 −1 −1 −1 −1 1 1 −1 −1 −1 −1 1 |
| | −1 1 −1 −1 1 1 −1 1 −1 −1 1 −1 1 −1 1 1 −1 1 −1 −1 1 1 −1 −1 1 1 −1 1 −1 1 −1 |
| | −1 −1 −1 −1 −1 −1 1 1 −1 −1 1 1 −1 −1 −1 −1 1 1 1 1 1 1 −1 −1 −1 −1 1 1 −1 −1 |
| | −1 −1 −1 1 −1 1 1 −1 −1 1 −1 1 1 −1 1 −1 1 −1 1 −1 1 −1 −1 1 1 −1 −1 1 1 −1 1 |
| | −1 1 −1 −1 −1 −1 −1 −1 −1 1 1 −1 −1 1 1 −1 −1 −1 −1 1 1 1 1 1 1 −1 −1 −1 −1 1 |
| | 1 −1 −1 −1 −1 −1 1 −1 1 1 −1 −1 1 −1 1 1 −1 1 −1 1 −1 1 −1 1 −1 −1 1 1 −1 −1 1 |
| | 1 −1 1 −1 1 −1 −1 −1 −1 −1 −1 −1 1 1 −1 −1 1 1 −1 −1 −1 −1 −1 −1 −1 −1 −1 −1 |
| | 1 1 1 1 −1 −1 1 1 1 1 −1 1 −1 1 1 −1 −1 1 −1 1 1 −1 1 −1 1 −1 −1 1 −1 1 1 −1 −1 |
| | 1 1 −1 −1 1 −1 1 −1 1 −1 −1 −1 −1 −1 −1 1 1 −1 −1 1 1 −1 −1 −1 −1 −1 −1 −1 |
| | −1 −1 −1 1 1 1 1 −1 −1 1 1 1 1 −1 1 −1 1 1 −1 −1 1 −1 1 1 −1 1 −1 1 −1 −1 1 −1 |
| | 1 1 −1 −1 1 1 −1 −1 1 −1 1 −1 1 −1 −1 −1 −1 −1 −1 1 1 −1 −1 1 1 −1 −1 −1 −1 1 |
| | 1 1 1 1 1 −1 −1 −1 −1 1 1 −1 −1 −1 −1 −1 1 −1 1 1 −1 −1 1 −1 1 1 −1 1 −1 1 −1 |
| | 1 −1 1 −1 −1 1 1 −1 −1 1 1 −1 1 −1 1 −1 1 1 1 1 1 1 −1 −1 1 1 −1 −1 1 1 1 1 −1 |
| | −1 −1 −1 −1 −1 1 1 1 1 −1 −1 1 1 1 1 1 −1 1 −1 −1 1 1 −1 1 −1 −1 1 −1 1 −1 1 |
| | −1 1 −1 1 1 −1 −1 1 1 −1 −1 1 −1 1 −1 1 −1 −1 −1 −1 −1 −1 1 1 −1 −1 1 1 −1 −1 |
| | −1 −1 −1 −1 −1 −1 −1 −1 1 1 1 1 −1 −1 1 1 1 1 −1 1 −1 1 1 −1 −1 1 −1 1 1 −1 1 |
| | −1 1 −1 −1 1 −1 1 1 −1 −1 1 1 −1 −1 1 −1 1 1 1 1 1 1 1 1 −1 −1 1 1 −1 −1 1 1 |
| | 1 1 1 1 1 1 1 1 −1 −1 −1 −1 1 1 −1 −1 −1 −1 1 −1 1 −1 −1 1 1 −1 1 −1 −1 1 −1 1 |
| | −1 1 1 −1 1 −1 −1 1 1 −1 −1 1 1 −1 1 −1 1 −1 −1 −1 −1 −1 −1 −1 1 1 −1 −1 1 1 |
| | −1 −1 −1 −1 1 1 1 1 1 1 −1 −1 −1 −1 1 1 −1 −1 −1 −1 −1 1 −1 1 1 −1 −1 1 −1 1 1 |
| | −1 1 −1 1 −1 1 −1 1 −1 −1 1 1 −1 −1 1 1 −1 1 −1 1 −1 −1 −1 −1 −1 −1 −1 1 1 −1 |
| | −1 1 1 −1 −1 −1 −1 1 1 1 1 1 1 −1 −1 −1 −1 1 1 −1 −1 −1 −1 −1 1 −1 1 1 −1 −1 1 |
| | −1 1 1 −1 1 −1 1 −1 1 −1 1 −1 −1 1 1 −1 −1 1 1 −1 1 −1 1 −1 −1 −1 −1 −1 −1 −1 |
| | 1 1 −1 −1 1 1 −1 −1 −1 −1 −1 −1 −1 −1 −1 −1 1 1 1 1 −1 −1 1 1 1 1 −1 1 −1 1 1 |
| | −1 −1 1 −1 1 1 −1 1 −1 1 −1 −1 1 −1 1 1 −1 −1 1 1 −1 −1 1 −1 1 −1 1 −1 −1 −1 |
| | −1 −1 −1 1 1 −1 1 1 −1 −1 −1 −1 −1 −1 −1 −1 −1 −1 1 1 1 1 −1 −1 1 1 1 1 −1 |
| | 1 −1 1 1 −1 −1 1 −1 1 1 −1 1 −1 1 −1 −1 1 −1 1 1 −1 −1 1 1 −1 −1 1 −1 1 −1 1 |
| | −1 −1 −1 −1 −1 −1 1 1 −1 −1 1 1 −1 −1 −1 −1 1 1 1 1 1 1 −1 −1 −1 −1 1 1 −1 −1 |
| | −1 −1 −1 1 −1 1 1 −1 −1 1 −1 1 1 −1 1 −1 1 −1 1 −1 1 −1 −1 1 1 −1 −1 1 1 −1 1 |
| | −1 1 −1 1 1 1 1 1 1 −1 −1 1 1 −1 −1 1 1 1 1 −1 −1 −1 −1 −1 −1 1 1 1 1 −1 −1 1 1 |
| | 1 1 1 −1 1 −1 −1 1 1 −1 1 −1 −1 1 −1 1 −1 1 −1 1 −1 1 1 −1 −1 1 1 −1 −1 1 −1 1 |
| | −1 1 1 1 1 1 1 1 −1 −1 1 1 −1 −1 1 1 1 1 1 1 1 1 1 1 −1 −1 −1 −1 1 1 −1 −1 −1 −1 |
| | 1 −1 1 −1 −1 1 1 −1 1 −1 −1 1 −1 1 −1 1 1 −1 1 −1 −1 1 1 −1 −1 1 1 −1 1 −1 1 |
| | −1 −1 −1 −1 −1 −1 −1 1 1 −1 −1 1 1 −1 −1 −1 −1 −1 −1 −1 −1 −1 −1 1 1 1 1 −1 |
| | −1 1 1 1 1 −1 1 −1 1 1 −1 −1 1 −1 1 1 −1 1 −1 1 −1 −1 1 −1 1 1 −1 −1 1 1 −1 −1 |
| | 1 −1 1 −1 1 1 1 1 1 1 1 −1 −1 1 1 −1 −1 1 1 1 1 −1 −1 −1 −1 −1 −1 1 1 1 1 −1 −1 |
| | 1 1 1 1 1 −1 1 −1 −1 1 1 −1 1 −1 −1 1 −1 1 −1 1 −1 1 −1 1 1 −1 −1 1 1 −1 −1 1 |
| | −1 1 −1 1 1 1 1 1 1 1 −1 −1 1 1 −1 −1 1 1 1 1 −1 −1 −1 −1 −1 −1 1 1 1 1 −1 −1 1 |
| | 1 1 1 1 −1 1 −1 −1 1 1 −1 1 −1 −1 1 −1 1 −1 1 −1 1 −1 1 1 −1 −1 1 1 −1 −1 1 −1 |
| | 1 −1 1 1 1 1 1 1 1 −1 −1 1 1 −1 −1 1 1 1 1 1 1 1 1 1 1 −1 −1 −1 −1 1 1 −1 −1 −1 |
| | −1 1 −1 1 −1 −1 1 1 −1 1 −1 −1 1 −1 1 −1 1 1 −1 1 −1 −1 1 1 −1 −1 1 1 −1 1 −1 |
| | 1 −1 1 1 1 1 1 1 −1 −1 1 1 −1 −1 1 1 1 1 1 1 1 1 1 1 −1 −1 −1 −1 1 1 −1 −1 −1 −1 |
| | 1 −1 1 −1 −1 1 1 −1 1 −1 −1 1 −1 1 −1 1 1 −1 1 −1 −1 1 1 −1 −1 1 1 −1 1 −1 1 |
| | −1 1 1 1 1 1 1 −1 −1 1 1 −1 −1 1 1 1 1 −1 −1 −1 −1 −1 −1 1 1 1 1 −1 −1 1 1 1 1 1 |
| | −1 1 −1 −1 1 1 −1 1 −1 −1 1 −1 1 −1 1 −1 1 −1 1 1 −1 −1 1 1 −1 −1 1 −1 1 −1 1 |
| | −1 −1 −1 −1 −1 −1 1 1 −1 −1 1 1 −1 −1 −1 −1 1 1 1 1 1 1 −1 −1 −1 −1 1 1 −1 −1 |
| | −1 −1 −1 1 −1 1 1 −1 −1 1 −1 1 1 −1 1 −1 1 −1 1 −1 1 −1 −1 1 1 −1 −1 1 1 −1 1 |
| | −1 1 −1 −1 −1 −1 −1 −1 −1 1 1 −1 −1 1 1 −1 −1 −1 −1 −1 −1 −1 −1 −1 −1 1 1 1 |
| | 1 −1 −1 1 1 1 1 −1 1 −1 1 1 −1 −1 1 −1 1 1 −1 1 −1 1 −1 −1 1 −1 1 1 −1 −1 1 1 |
| | −1 −1 1 −1 1 −1 1 1 1 1 1 1 1 −1 −1 1 1 −1 −1 1 1 1 1 1 1 1 1 1 1 −1 −1 −1 −1 1 |
| | 1 −1 −1 −1 −1 1 −1 1 −1 −1 1 1 −1 1 −1 −1 1 −1 1 −1 1 1 −1 1 −1 −1 1 1 −1 −1 1 |
| | 1 −1 1 −1 1 −1 −1 −1 −1 −1 −1 −1 1 1 −1 −1 1 1 −1 −1 −1 −1 1 1 1 1 1 1 −1 −1 |
| | −1 −1 1 1 −1 −1 −1 −1 −1 1 −1 1 1 −1 −1 1 −1 1 1 −1 1 −1 1 −1 1 −1 1 −1 −1 1 1 |
| | −1 −1 1 1 −1 1 −1 1 −1 −1 −1 −1 −1 −1 −1 1 1 −1 −1 1 1 −1 −1 −1 −1 1 1 1 1 1 1 |
| | −1 −1 −1 −1 1 −1 −1 −1 −1 1 −1 1 1 −1 −1 1 −1 1 1 −1 1 −1 1 −1 1 −1 1 −1 |
| | −1 1 1 −1 −1 1 1 −1 1 −1 1 −1 1 1 1 1 1 1 −1 −1 1 1 −1 −1 1 1 1 1 1 1 1 1 1 1 −1 |
| | −1 −1 −1 1 1 −1 −1 −1 −1 1 −1 1 −1 −1 1 1 −1 1 −1 −1 1 −1 1 −1 1 1 −1 1 −1 −1 |
| | 1 1 −1 −1 1 1 −1 1 −1 1 −1 1 1 1 1 1 1 −1 −1 1 1 −1 −1 1 1 1 1 1 1 1 1 1 1 −1 −1 |
| | −1 −1 1 1 −1 −1 −1 −1 1 −1 1 −1 −1 1 1 −1 1 −1 −1 1 −1 1 −1 1 1 −1 1 −1 −1 1 1 |
| | −1 −1 1 1 −1 1 −1 1 −1 1 1 1 1 1 1 −1 −1 1 1 −1 −1 1 1 1 1 −1 −1 −1 −1 −1 −1 1 |
| | 1 1 1 −1 −1 1 1 1 1 1 −1 1 −1 −1 1 1 −1 1 −1 −1 1 −1 1 −1 1 −1 1 −1 1 1 −1 −1 1 |
| | 1 −1 −1 1 −1 1 −1 1 −1 −1 −1 −1 −1 −1 1 1 −1 −1 1 1 −1 −1 −1 −1 1 1 1 1 1 1 −1 |
| | −1 −1 −1 1 1 −1 −1 −1 −1 −1 1 −1 1 1 −1 −1 1 −1 1 1 −1 1 −1 1 −1 1 −1 1 −1 −1 |
| | 1 1 −1 −1 1 1 −1 1 −1 1 −1 1 1 1 1 1 1 −1 −1 1 1 −1 −1 1 1 1 1 1 1 1 1 1 1 −1 −1 |
| | −1 −1 1 1 −1 −1 −1 −1 1 −1 1 −1 −1 1 1 −1 1 −1 −1 1 −1 1 −1 1 1 −1 1 −1 −1 1 1 |
| | −1 −1 1 1 −1 1 −1 1 −1 −1 −1 −1 −1 −1 −1 1 1 −1 −1 1 1 −1 −1 −1 −1 −1 −1 −1 |
| | −1 −1 −1 1 1 1 1 −1 −1 1 1 1 1 −1 1 −1 1 1 −1 −1 1 −1 1 1 −1 1 −1 1 −1 −1 1 −1 |
| | 1 1 −1 −1 1 1 −1 −1 1 −1 1 −1 1 1 1 1 1 1 1 −1 −1 1 1 −1 −1 1 1 1 1 −1 −1 −1 −1 |
| | −1 −1 1 1 1 1 −1 −1 1 1 1 1 1 −1 1 −1 −1 1 1 −1 1 −1 −1 1 −1 1 −1 1 −1 1 −1 1 1 |
| | −1 −1 1 1 −1 −1 1 −1 1 −1 1 1 1 1 1 1 1 −1 −1 1 1 −1 −1 1 1 1 1 −1 −1 −1 −1 −1 |
| | −1 1 1 1 1 −1 −1 1 1 1 1 1 −1 1 −1 −1 1 −1 −1 1 −1 1 −1 1 −1 1 −1 1 1 −1 |
| | −1 1 1 −1 −1 1 −1 1 −1 1 −1 −1 −1 −1 −1 −1 1 1 −1 −1 1 1 −1 −1 −1 −1 −1 −1 |
| | −1 −1 −1 −1 1 1 1 1 −1 −1 1 1 1 1 −1 1 −1 1 1 −1 −1 1 −1 1 1 −1 1 −1 1 −1 −1 1 |
| | −1 1 1 −1 −1 1 1 −1 −1 1 −1 1 −1 1 −1 −1 −1 −1 −1 −1 1 1 −1 −1 1 1 −1 −1 −1 |
| | −1 −1 −1 −1 −1 −1 −1 1 1 1 1 −1 −1 1 1 1 1 −1 1 −1 1 1 −1 −1 1 −1 1 1 −1 1 −1 |
| | 1 −1 −1 1 −1 1 1 −1 −1 1 1 −1 −1 1 −1 1 −1 1 −1 −1 −1 −1 −1 −1 1 1 −1 −1 1 1 |
| | −1 −1 −1 −1 1 1 1 1 1 1 −1 −1 −1 −1 1 1 −1 −1 −1 −1 −1 1 −1 1 1 −1 −1 1 −1 1 1 |
| | −1 1 −1 1 −1 1 −1 1 −1 −1 1 1 −1 −1 1 1 −1 1 −1 1 −1 1 1 1 1 1 1 −1 −1 1 1 −1 |
| | −1 1 1 1 1 −1 −1 −1 −1 −1 −1 1 1 1 1 −1 −1 1 1 1 1 1 −1 1 −1 −1 1 1 −1 1 −1 −1 |
| | 1 −1 1 −1 1 −1 1 −1 1 1 −1 −1 1 1 −1 −1 1 −1 1 −1 1 −1 −1 −1 −1 −1 −1 1 1 −1 |
| | −1 1 1 −1 −1 −1 −1 −1 −1 −1 −1 −1 −1 1 1 1 1 −1 −1 1 1 1 1 −1 1 −1 1 1 −1 −1 1 |
| | −1 1 1 −1 1 −1 1 −1 −1 1 −1 1 1 −1 −1 1 1 −1 −1 1 −1 1 −1 1 1 1 1 1 1 1 −1 −1 1 |
| | 1 −1 −1 1 1 1 1 1 1 1 1 1 1 −1 −1 −1 −1 1 1 −1 −1 −1 −1 1 −1 1 −1 −1 1 1 −1 1 |
| | −1 −1 1 −1 1 −1 1 1 −1 1 −1 −1 1 1 −1 −1 1 1 −1 1 −1 1 −1 −1 −1 −1 −1 −1 −1 1 |
| | 1 −1 −1 1 1 −1 −1 −1 −1 1 1 1 1 1 1 −1 −1 −1 −1 1 1 −1 −1 −1 −1 −1 1 −1 1 1 −1 |
| | −1 1 −1 1 1 −1 1 −1 1 −1 1 −1 1 −1 −1 1 1 −1 −1 1 1 −1 1 −1 1 −1 −1 −1 −1 −1 |
| | −1 −1 1 1 −1 −1 1 1 −1 −1 −1 −1 1 1 1 1 1 1 −1 −1 −1 −1 1 1 −1 −1 −1 −1 −1 1 |
| | −1 1 1 −1 −1 1 −1 1 1 −1 1 −1 1 −1 1 −1 1 −1 −1 1 1 −1 −1 1 1 −1 1 −1 1 −1 1 1 |
| | 1 1 1 1 −1 −1 1 1 −1 −1 1 1 1 1 1 1 1 1 1 −1 −1 −1 −1 1 1 −1 −1 −1 −1 1 −1 1 |
| | −1 −1 1 1 −1 1 −1 −1 1 −1 1 −1 1 1 −1 1 −1 −1 1 1 −1 −1 1 1 −1 1 −1 1 −1 1 1 1 |
| | 1 1 1 −1 −1 1 1 −1 −1 1 1 1 1 1 1 1 1 1 1 −1 −1 −1 −1 1 1 −1 −1 −1 −1 1 −1 1 −1 |
| | −1 1 1 −1 1 −1 −1 1 −1 1 −1 1 1 −1 1 −1 −1 1 1 −1 −1 1 1 −1 1 −1 1 −1 1 1 1 1 1 |
| | 1 −1 −1 1 1 −1 −1 1 1 1 1 −1 −1 −1 −1 −1 −1 1 1 1 1 −1 −1 1 1 1 1 1 −1 1 −1 −1 |
| | 1 1 −1 1 −1 −1 1 −1 1 −1 1 −1 1 −1 1 1 −1 −1 1 1 −1 −1 1 −1 1 −1 1 −1 −1 −1 −1 |
| | −1 −1 1 1 −1 −1 1 1 −1 −1 −1 −1 1 1 1 1 1 1 −1 −1 −1 −1 1 1 −1 −1 −1 −1 −1 1 |
| | −1 1 1 −1 −1 1 −1 1 1 −1 1 −1 1 −1 1 −1 1 −1 −1 1 1 −1 −1 1 1 −1 1 −1 1 −1 −1 |
| | −1 −1 −1 −1 −1 1 1 −1 −1 1 1 −1 −1 −1 −1 −1 −1 −1 −1 −1 −1 1 1 1 1 −1 −1 1 1 |
| | 1 1 −1 1 −1 1 1 −1 −1 1 −1 1 1 −1 1 −1 1 −1 −1 1 −1 1 1 −1 −1 1 1 −1 −1 1 −1 1 |
| | −1 1 1 1 1 1 1 1 −1 −1 1 1 −1 −1 1 1 1 1 1 1 1 1 1 1 −1 −1 −1 −1 1 1 −1 −1 −1 −1 |
| | 1 −1 1 −1 −1 1 1 −1 1 −1 −1 1 −1 1 −1 1 1 −1 1 −1 −1 1 1 −1 −1 1 1 −1 1 −1 1 |
| | −1 −1 −1 −1 −1 −1 −1 1 1 −1 −1 1 1 −1 −1 −1 −1 1 1 1 1 1 1 −1 −1 −1 −1 1 1 −1 |
| | −1 −1 −1 −1 1 −1 1 1 −1 −1 1 −1 1 1 −1 1 −1 1 −1 1 −1 1 −1 −1 1 1 −1 −1 1 1 −1 |
| | 1 −1 1 −1 −1 −1 −1 −1 −1 −1 1 1 −1 −1 1 1 −1 −1 −1 −1 1 1 1 1 1 1 −1 −1 −1 −1 |
| | 1 1 −1 −1 −1 −1 −1 1 −1 1 1 −1 −1 1 −1 1 1 −1 1 −1 1 −1 1 −1 1 −1 −1 1 1 −1 −1 |
| | 1 1 −1 1 −1 1 −1 1 1 1 1 1 1 −1 −1 1 1 −1 −1 1 1 1 1 1 1 1 1 1 1 −1 −1 −1 −1 1 1 |
| | −1 −1 −1 −1 1 −1 1 −1 −1 1 1 −1 1 −1 −1 1 −1 1 −1 1 1 −1 1 −1 −1 1 1 −1 −1 1 1 |
| | −1 1 −1 1 −1 1 1 1 1 1 1 −1 −1 1 1 −1 −1 1 1 1 1 1 1 1 1 1 1 −1 −1 −1 −1 1 1 −1 |
| | −1 −1 −1 1 −1 1 −1 −1 1 1 −1 1 −1 −1 1 −1 1 −1 1 1 −1 1 −1 −1 1 1 −1 −1 1 1 −1 |
| | 1 −1 1 −1 1 1 1 1 1 1 −1 −1 1 1 −1 −1 1 1 1 1 −1 −1 −1 −1 −1 −1 1 1 1 1 −1 −1 1 |
| | 1 1 1 1 −1 1 −1 −1 1 1 −1 1 −1 −1 1 −1 1 −1 1 −1 1 −1 1 1 −1 −1 1 1 −1 −1 1 −1 |
| | 1 −1 1 −1 −1 −1 −1 −1 −1 1 1 −1 −1 1 1 −1 −1 −1 −1 1 1 1 1 1 1 −1 −1 −1 −1 1 1 |
| | −1 −1 −1 −1 −1 1 −1 1 1 −1 −1 1 −1 1 1 −1 1 −1 1 −1 1 −1 1 −1 −1 1 1 −1 −1 1 1 |
| | −1 1 −1 1 −1 −1 −1 −1 −1 −1 −1 1 1 −1 −1 1 1 −1 −1 −1 −1 −1 −1 −1 −1 −1 −1 1 |
| | 1 1 1 −1 −1 1 1 1 1 −1 1 −1 1 1 −1 −1 1 −1 1 1 −1 1 −1 1 −1 −1 1 −1 1 1 −1 −1 1 |
| | 1 −1 −1 1 −1 1 −1 1 1 1 1 1 1 1 −1 −1 1 1 −1 1 1 1 1 1 1 1 1 1 1 −1 −1 −1 −1 |
| | 1 1 −1 −1 −1 −1 1 −1 1 −1 −1 1 1 −1 1 −1 −1 1 −1 1 −1 1 1 −1 1 −1 −1 1 1 −1 −1 |
| | 1 1 −1 1 −1 1 −1 −1 −1 −1 −1 −1 −1 1 1 −1 −1 1 1 −1 −1 −1 −1 1 1 1 1 1 1 −1 −1 |
| | −1 −1 1 1 −1 −1 −1 −1 −1 1 −1 1 1 −1 −1 1 −1 1 1 −1 1 −1 1 −1 1 −1 1 −1 −1 1 1 |
| | −1 −1 1 1 −1 1 −1 1 −1 −1 −1 −1 −1 −1 −1 1 1 −1 −1 1 1 −1 −1 −1 −1 1 1 1 1 1 1 |
| | −1 −1 −1 −1 1 1 −1 −1 −1 −1 −1 1 −1 1 1 −1 −1 1 −1 1 1 −1 1 −1 1 −1 1 −1 1 −1 |
| | −1 1 1 −1 −1 1 1 −1 1 −1 1 −1 |
| 6 | 1 1 1 1 1 1 1 1 1 1 −1 −1 1 1 −1 −1 1 1 −1 −1 −1 −1 1 1 1 1 1 1 −1 −1 −1 −1 1 1 |
| | 1 1 1 1 1 1 −1 −1 1 1 −1 −1 1 1 1 1 −1 −1 −1 −1 1 1 −1 −1 −1 −1 1 1 1 1 1 −1 1 |
| | −1 1 −1 1 −1 1 −1 −1 1 1 −1 −1 1 1 −1 −1 1 −1 1 1 −1 1 −1 1 −1 −1 1 −1 1 1 −1 |
| | 1 −1 1 −1 1 −1 −1 1 1 −1 −1 1 1 −1 1 −1 −1 1 −1 1 1 −1 −1 1 −1 1 1 −1 1 −1 1 1 |
| | 1 1 1 1 1 1 1 1 −1 −1 1 1 −1 −1 1 1 −1 −1 −1 −1 1 1 1 1 1 1 −1 −1 −1 −1 −1 −1 |
| | −1 −1 −1 −1 −1 −1 1 1 −1 −1 1 1 −1 −1 −1 −1 1 1 1 1 −1 −1 1 1 1 1 −1 −1 −1 −1 |
| | 1 −1 1 −1 1 −1 1 −1 1 −1 −1 1 1 −1 −1 1 1 −1 −1 1 −1 1 1 −1 1 −1 1 −1 −1 1 −1 |
| | 1 −1 1 −1 1 −1 1 −1 1 1 −1 −1 1 1 −1 −1 1 −1 1 1 −1 1 −1 −1 1 1 −1 1 −1 −1 1 |
| | −1 1 1 1 1 1 1 1 1 1 1 1 −1 −1 1 1 −1 −1 1 1 −1 −1 −1 −1 1 1 1 1 −1 −1 −1 −1 |
| | 1 1 1 1 1 1 1 1 −1 −1 1 1 −1 −1 1 1 1 1 −1 −1 −1 −1 1 1 −1 −1 −1 −1 1 1 1 1 1 −1 |
| | 1 −1 1 −1 1 −1 1 −1 −1 1 1 −1 −1 1 1 −1 −1 1 −1 1 1 −1 1 −1 1 −1 −1 1 −1 1 1 |
| | −1 1 −1 1 −1 1 −1 −1 1 1 −1 −1 1 1 −1 1 −1 −1 1 −1 1 1 −1 −1 1 −1 1 1 −1 1 −1 |
| | −1 −1 −1 −1 −1 −1 −1 −1 −1 −1 1 1 −1 −1 1 1 −1 −1 1 1 1 1 −1 −1 −1 −1 −1 −1 |
| | 1 1 1 1 1 1 1 1 1 1 1 1 −1 −1 1 1 −1 −1 1 1 1 1 −1 −1 −1 −1 1 1 −1 −1 −1 −1 1 1 |
| | 1 1 −1 1 −1 1 −1 1 −1 1 −1 1 1 −1 −1 1 1 −1 −1 1 1 −1 1 −1 −1 1 −1 1 −1 1 1 −1 |
| | 1 −1 1 −1 1 −1 1 −1 1 −1 −1 1 1 −1 −1 1 1 −1 1 −1 −1 1 −1 1 1 −1 −1 1 −1 1 1 |
| | −1 1 −1 1 1 1 1 1 1 1 1 1 1 −1 −1 1 1 −1 −1 1 1 −1 −1 −1 −1 1 1 1 1 1 1 −1 −1 −1 |
| | −1 1 1 1 1 1 1 1 1 −1 −1 1 1 −1 −1 1 1 1 1 −1 −1 −1 −1 1 1 −1 −1 −1 −1 1 1 1 1 1 |
| | −1 1 −1 1 −1 1 −1 1 −1 −1 1 1 −1 −1 1 1 −1 −1 1 −1 1 1 −1 1 −1 1 −1 −1 1 −1 1 |
| | 1 −1 1 −1 1 −1 1 −1 −1 1 1 −1 −1 1 1 −1 1 −1 −1 1 −1 1 1 −1 −1 1 −1 1 1 −1 1 |
| | −1 1 1 1 1 1 1 1 1 1 1 −1 −1 1 1 −1 −1 1 1 −1 −1 −1 −1 1 1 1 1 1 1 −1 −1 −1 −1 |
| | −1 −1 −1 −1 −1 −1 −1 −1 1 1 −1 −1 1 1 −1 −1 −1 −1 1 1 1 1 −1 −1 1 1 1 1 −1 −1 |
| | −1 −1 1 −1 1 −1 1 −1 1 −1 1 −1 −1 1 1 −1 −1 1 1 −1 −1 1 −1 1 1 −1 1 −1 1 −1 −1 |
| | 1 −1 1 −1 1 −1 1 −1 1 −1 1 1 −1 −1 1 1 −1 −1 1 −1 1 1 −1 1 −1 −1 1 1 −1 1 −1 |
| | −1 1 −1 1 −1 −1 −1 −1 −1 −1 −1 −1 −1 −1 1 1 −1 −1 1 1 −1 −1 1 1 1 1 −1 −1 −1 |
| | −1 −1 −1 1 1 1 1 −1 −1 −1 −1 −1 −1 −1 −1 1 1 −1 −1 1 1 −1 −1 −1 −1 1 1 1 1 −1 |
| | −1 1 1 1 1 −1 −1 −1 −1 −1 1 −1 1 −1 1 −1 1 −1 1 1 −1 −1 1 1 −1 −1 1 1 −1 1 −1 |
| | −1 1 −1 1 −1 1 1 −1 1 −1 −1 1 −1 1 −1 1 −1 1 1 −1 −1 1 1 −1 −1 1 −1 1 1 −1 1 |
| | −1 −1 1 1 −1 1 −1 −1 1 −1 1 1 1 1 1 1 1 1 1 1 1 −1 −1 1 1 −1 −1 1 1 −1 −1 −1 −1 |
| | 1 1 1 1 1 1 −1 −1 −1 −1 −1 −1 −1 −1 −1 −1 −1 −1 1 1 −1 −1 1 1 −1 −1 −1 −1 1 1 |
| | 1 1 −1 −1 1 1 1 1 −1 −1 −1 −1 1 −1 1 −1 1 −1 1 −1 1 −1 −1 1 1 −1 −1 1 1 −1 −1 |
| | 1 −1 1 1 −1 1 −1 1 −1 −1 1 −1 1 −1 1 −1 1 −1 1 −1 1 1 −1 −1 1 1 −1 −1 1 −1 1 1 |
| | −1 1 −1 −1 1 1 −1 1 −1 −1 1 −1 1 1 1 1 1 −1 −1 −1 −1 1 1 −1 −1 −1 −1 1 1 1 1 |
| | −1 −1 1 1 −1 −1 1 1 1 1 1 1 1 1 1 1 1 1 −1 −1 −1 −1 −1 −1 1 1 1 1 −1 −1 1 1 −1 |
| | −1 1 1 −1 −1 −1 −1 −1 −1 −1 −1 −1 −1 −1 1 −1 1 1 −1 1 −1 −1 1 1 −1 1 −1 −1 1 |
| | −1 1 1 −1 −1 1 1 −1 −1 1 −1 1 −1 1 −1 1 −1 1 −1 1 1 −1 1 −1 1 −1 −1 1 −1 1 1 |
| | −1 −1 1 1 −1 −1 1 1 −1 1 −1 1 −1 1 −1 1 −1 1 1 1 1 −1 −1 −1 −1 1 1 −1 −1 −1 −1 |
| | 1 1 1 1 −1 −1 1 1 −1 −1 1 1 1 1 1 1 1 1 −1 −1 −1 −1 1 1 1 1 1 1 −1 −1 −1 −1 1 1 |
| | −1 −1 1 1 −1 −1 1 1 1 1 1 1 1 1 1 1 −1 1 −1 1 1 −1 1 −1 −1 1 1 −1 1 −1 −1 1 −1 1 |
| | 1 −1 −1 1 1 −1 −1 1 −1 1 −1 1 −1 1 1 −1 1 −1 −1 1 −1 1 −1 1 1 −1 1 −1 −1 1 1 |
| | −1 −1 1 1 −1 −1 1 −1 1 −1 1 −1 1 −1 1 1 1 1 1 −1 −1 −1 −1 1 1 −1 −1 −1 −1 1 1 |
| | 1 1 −1 −1 1 1 −1 −1 1 1 1 1 1 1 1 1 1 1 1 1 −1 −1 −1 −1 −1 −1 1 1 1 1 −1 −1 1 1 |
| | −1 −1 1 1 −1 −1 −1 −1 −1 −1 −1 −1 −1 −1 −1 1 −1 1 1 −1 1 −1 −1 1 1 −1 1 −1 |
| | −1 1 −1 1 1 −1 −1 1 1 −1 −1 1 −1 1 −1 1 −1 1 −1 1 −1 1 1 −1 1 −1 1 −1 −1 1 −1 |
| | 1 1 −1 −1 1 1 −1 −1 1 1 −1 1 −1 1 −1 1 −1 1 −1 −1 −1 −1 −1 1 1 1 1 −1 −1 1 1 1 |
| | 1 −1 −1 −1 −1 1 1 −1 −1 1 1 −1 −1 −1 −1 −1 −1 −1 −1 1 1 1 1 −1 −1 −1 −1 −1 |
| | −1 1 1 1 1 −1 −1 1 1 −1 −1 1 1 −1 −1 −1 −1 −1 −1 −1 −1 −1 −1 1 −1 1 −1 −1 1 |
| | −1 1 1 −1 −1 1 −1 1 1 −1 1 −1 −1 1 1 −1 −1 1 1 −1 1 −1 1 −1 1 −1 −1 1 −1 1 1 |
| | −1 1 −1 1 −1 −1 1 −1 1 1 −1 −1 1 1 −1 −1 1 1 −1 1 −1 1 −1 1 −1 1 −1 1 1 1 1 −1 |
| | −1 −1 −1 1 1 −1 −1 −1 −1 1 1 1 1 −1 −1 1 1 −1 −1 1 1 1 1 1 1 1 1 1 1 1 1 −1 −1 |
| | −1 −1 −1 −1 1 1 1 1 −1 −1 1 1 −1 −1 1 1 −1 −1 −1 −1 −1 −1 −1 −1 −1 −1 −1 1 |
| | −1 1 1 −1 1 −1 −1 1 1 −1 1 −1 −1 1 −1 1 1 −1 −1 1 1 −1 −1 1 −1 1 −1 1 −1 1 −1 |
| | 1 −1 1 1 −1 1 −1 1 −1 −1 1 −1 1 1 −1 −1 1 1 −1 −1 1 1 −1 1 −1 1 −1 1 −1 1 −1 1 |
| | 1 1 1 −1 −1 −1 −1 1 1 −1 −1 −1 −1 1 1 1 1 −1 −1 1 1 −1 −1 1 1 1 1 1 1 1 1 −1 −1 |
| | −1 −1 1 1 1 1 1 1 −1 −1 −1 −1 1 1 −1 −1 1 1 −1 −1 1 1 1 1 1 1 1 1 1 1 −1 1 −1 1 |
| | 1 −1 1 −1 −1 1 1 −1 1 −1 −1 1 −1 1 1 −1 −1 1 1 −1 −1 1 −1 1 −1 1 −1 1 1 −1 1 |
| | −1 −1 1 −1 1 −1 1 1 −1 1 −1 −1 1 1 −1 −1 1 1 −1 −1 1 −1 1 −1 1 −1 1 −1 1 −1 −1 |
| | −1 −1 1 1 1 1 −1 −1 1 1 1 1 −1 −1 −1 −1 1 1 −1 −1 1 1 −1 −1 −1 −1 −1 −1 −1 −1 |
| | −1 −1 −1 −1 1 1 1 1 1 1 −1 −1 −1 −1 1 1 −1 −1 1 1 −1 −1 1 1 1 1 1 1 1 1 1 1 1 −1 |
| | 1 −1 −1 1 −1 1 1 −1 −1 1 −1 1 1 −1 1 −1 −1 1 1 −1 −1 1 1 −1 1 −1 1 −1 1 −1 1 |
| | −1 1 −1 −1 1 −1 1 −1 1 1 −1 1 −1 −1 1 1 −1 −1 1 1 −1 −1 1 −1 1 −1 1 −1 1 −1 1 |
| | 1 1 1 1 −1 −1 −1 −1 1 1 −1 −1 −1 −1 1 1 1 1 −1 −1 1 1 −1 −1 1 1 1 1 1 1 1 1 −1 |
| | −1 −1 −1 1 1 1 1 1 1 −1 −1 −1 −1 1 1 −1 −1 1 1 −1 −1 1 1 1 1 1 1 1 1 1 1 −1 1 −1 |
| | 1 1 −1 1 −1 −1 1 1 −1 1 −1 −1 1 −1 1 1 −1 −1 1 1 −1 −1 1 −1 1 −1 1 −1 1 1 −1 1 |
| | −1 −1 1 −1 1 −1 1 1 −1 1 −1 −1 1 1 −1 −1 1 1 −1 −1 1 −1 1 −1 1 −1 1 −1 1 1 1 1 |
| | 1 1 1 1 1 1 1 −1 −1 1 1 −1 −1 1 1 −1 −1 −1 −1 1 1 1 1 1 1 −1 −1 −1 −1 1 1 1 1 1 |
| | 1 1 1 −1 −1 1 1 −1 −1 1 1 1 1 −1 −1 −1 −1 1 1 −1 −1 −1 −1 1 1 1 1 1 −1 1 −1 1 |
| | −1 1 −1 1 −1 −1 1 1 −1 −1 1 1 −1 −1 1 −1 1 1 −1 1 −1 1 −1 −1 1 −1 1 1 −1 1 −1 |
| | 1 −1 1 −1 −1 1 1 −1 −1 1 1 −1 1 −1 −1 1 −1 1 1 −1 −1 1 −1 1 1 −1 1 −1 1 1 1 1 1 |
| | 1 1 1 1 1 −1 −1 1 1 −1 −1 1 1 −1 −1 −1 −1 1 1 1 1 1 1 −1 −1 −1 −1 −1 −1 −1 −1 |
| | −1 −1 −1 −1 1 1 −1 −1 1 1 −1 −1 −1 −1 1 1 1 1 −1 −1 1 1 1 1 −1 −1 −1 −1 1 −1 1 |
| | −1 1 −1 1 −1 1 −1 −1 1 1 −1 −1 1 1 −1 −1 1 −1 1 1 −1 1 −1 1 −1 −1 1 −1 1 −1 1 |
| | −1 1 −1 1 −1 1 1 −1 −1 1 1 −1 −1 1 −1 1 1 −1 1 −1 −1 1 1 −1 1 −1 −1 1 −1 1 1 1 |
| | 1 1 1 1 1 1 1 1 −1 −1 1 1 −1 −1 1 1 −1 −1 −1 −1 1 1 1 1 1 1 −1 −1 −1 −1 1 1 1 1 |
| | 1 1 1 1 −1 −1 1 1 −1 −1 1 1 1 1 −1 −1 −1 −1 1 1 −1 −1 −1 −1 1 1 1 1 1 −1 1 −1 1 |
| | −1 1 −1 1 −1 −1 1 1 −1 −1 1 1 −1 −1 1 −1 1 1 −1 1 −1 1 −1 −1 1 −1 1 1 −1 1 −1 |
| | 1 −1 1 −1 −1 1 1 −1 −1 1 1 −1 1 −1 −1 1 −1 1 1 −1 −1 1 −1 1 1 −1 1 −1 −1 −1 −1 |
| | −1 −1 −1 −1 −1 −1 −1 1 1 −1 −1 1 1 −1 −1 1 1 1 1 −1 −1 −1 −1 −1 −1 1 1 1 1 1 1 |
| | 1 1 1 1 1 1 −1 −1 1 1 −1 −1 1 1 1 1 −1 −1 −1 −1 1 1 −1 −1 −1 −1 1 1 1 1 −1 1 −1 |
| | 1 −1 1 −1 1 −1 1 1 −1 −1 1 1 −1 −1 1 1 −1 1 −1 −1 1 −1 1 −1 1 1 −1 1 −1 1 −1 1 |
| | −1 1 −1 1 −1 −1 1 1 −1 −1 1 1 −1 1 −1 −1 1 −1 1 1 −1 −1 1 −1 1 1 −1 1 −1 −1 −1 |
| | −1 −1 −1 −1 −1 −1 −1 −1 1 1 −1 −1 1 1 −1 −1 1 1 1 1 −1 −1 −1 −1 −1 −1 1 1 1 1 |
| | −1 −1 −1 −1 −1 −1 −1 −1 1 1 −1 −1 1 1 −1 −1 −1 −1 1 1 1 1 −1 −1 1 1 1 1 −1 −1 |
| | −1 −1 −1 1 −1 1 −1 1 −1 1 −1 1 1 −1 −1 1 1 −1 −1 1 1 −1 1 −1 −1 1 −1 1 −1 1 1 |
| | −1 1 −1 −1 1 −1 1 −1 1 −1 1 1 −1 −1 1 1 −1 −1 1 −1 1 1 −1 1 −1 −1 1 1 −1 1 −1 |
| | −1 1 −1 1 −1 −1 −1 −1 −1 −1 −1 −1 −1 −1 1 1 −1 −1 1 1 −1 −1 1 1 1 1 −1 −1 −1 |
| | −1 −1 −1 1 1 1 1 1 1 1 1 1 1 1 1 −1 −1 1 1 −1 −1 1 1 1 1 −1 −1 −1 −1 1 1 −1 −1 |
| | −1 −1 1 1 1 1 −1 1 −1 1 −1 1 −1 1 −1 1 1 −1 −1 1 1 −1 −1 1 1 −1 1 −1 −1 1 −1 1 |
| | −1 1 1 −1 1 −1 1 −1 1 −1 1 −1 1 −1 −1 1 1 −1 −1 1 1 −1 1 −1 −1 1 −1 1 1 −1 −1 |
| | 1 −1 1 1 −1 1 −1 1 1 1 1 1 1 1 1 1 1 −1 −1 1 1 −1 −1 1 1 −1 −1 −1 −1 1 1 1 1 1 1 |
| | −1 −1 −1 −1 1 1 1 1 1 1 1 1 −1 −1 1 1 −1 −1 1 1 1 1 −1 −1 −1 −1 1 1 −1 −1 −1 |
| | −1 1 1 1 1 1 −1 1 −1 1 −1 1 −1 1 −1 −1 1 1 −1 −1 1 1 −1 −1 1 −1 1 1 −1 1 −1 1 |
| | −1 −1 1 −1 1 1 −1 1 −1 1 −1 1 −1 −1 1 1 −1 −1 1 1 −1 1 −1 −1 1 −1 1 1 −1 −1 1 |
| | −1 1 1 −1 1 −1 −1 −1 −1 −1 −1 −1 −1 −1 −1 −1 1 1 −1 −1 1 1 −1 −1 1 1 1 1 −1 |
| | −1 −1 −1 −1 −1 1 1 1 1 1 1 1 1 1 1 1 1 −1 −1 1 1 −1 −1 1 1 1 1 −1 −1 −1 −1 1 1 |
| | −1 −1 −1 −1 1 1 1 1 −1 1 −1 1 −1 1 −1 1 −1 1 1 −1 −1 1 1 −1 −1 1 1 −1 1 −1 −1 |
| | 1 −1 1 −1 1 1 −1 1 −1 1 −1 1 −1 1 −1 1 −1 −1 1 1 −1 −1 1 1 −1 1 −1 −1 1 −1 1 1 |
| | −1 −1 1 −1 1 1 −1 1 −1 1 1 1 1 −1 −1 −1 −1 1 1 −1 −1 −1 −1 1 1 1 1 −1 −1 1 1 |
| | −1 −1 1 1 1 1 1 1 1 1 1 1 1 1 −1 −1 −1 −1 −1 −1 1 1 1 1 −1 −1 1 1 −1 −1 1 1 −1 |
| | −1 −1 −1 −1 −1 −1 −1 −1 −1 −1 1 −1 1 1 −1 1 −1 −1 1 1 −1 1 −1 −1 1 −1 1 1 −1 |
| | −1 1 1 −1 −1 1 −1 1 −1 1 −1 1 −1 1 −1 1 1 −1 1 −1 1 −1 −1 1 −1 1 1 −1 −1 1 1 |
| | −1 −1 1 1 −1 1 −1 1 −1 1 −1 1 −1 1 1 1 1 −1 −1 −1 −1 1 1 −1 −1 −1 −1 1 1 1 1 |
| | −1 −1 1 1 −1 −1 1 1 1 1 1 1 1 1 −1 −1 −1 −1 1 1 1 1 1 1 −1 −1 −1 −1 1 1 −1 −1 1 |
| | 1 −1 −1 1 1 1 1 1 1 1 1 1 1 −1 1 −1 1 1 −1 1 −1 −1 1 1 −1 1 −1 −1 1 −1 1 1 −1 −1 |
| | 1 1 −1 −1 1 −1 1 −1 1 −1 1 1 −1 1 −1 −1 1 −1 1 −1 1 1 −1 1 −1 −1 1 1 −1 −1 1 1 |
| | −1 −1 1 −1 1 −1 1 −1 1 −1 1 1 1 1 1 −1 −1 −1 −1 1 1 −1 −1 −1 −1 1 1 1 1 −1 −1 |
| | 1 1 −1 −1 1 1 1 1 1 1 1 1 1 1 1 1 −1 −1 −1 −1 −1 −1 1 1 1 1 −1 −1 1 1 −1 −1 1 1 |
| | −1 −1 −1 −1 −1 −1 −1 −1 −1 −1 −1 1 −1 1 1 −1 1 −1 −1 1 1 −1 1 −1 −1 1 −1 1 1 |
| | −1 −1 1 1 −1 −1 1 −1 1 −1 1 −1 1 −1 1 −1 1 1 −1 1 −1 1 −1 −1 1 −1 1 1 −1 −1 1 |
| | 1 −1 −1 1 1 −1 1 −1 1 −1 1 −1 1 −1 −1 −1 −1 −1 1 1 1 1 −1 −1 1 1 1 1 −1 −1 −1 |
| | −1 1 1 −1 −1 1 1 −1 −1 −1 −1 −1 −1 −1 −1 1 1 1 1 −1 −1 −1 −1 −1 −1 1 1 1 1 −1 |
| | −1 1 1 −1 −1 1 1 −1 −1 −1 −1 −1 −1 −1 −1 −1 −1 1 −1 1 −1 −1 1 −1 1 1 −1 −1 1 |
| | −1 1 1 −1 1 −1 −1 1 1 −1 −1 1 1 −1 1 −1 1 −1 1 −1 −1 1 −1 1 1 −1 1 −1 1 −1 −1 |
| | 1 −1 1 1 −1 −1 1 1 −1 −1 1 1 −1 1 −1 1 −1 1 −1 1 −1 −1 −1 −1 −1 1 1 1 1 −1 −1 |
| | 1 1 1 1 −1 −1 −1 −1 1 1 −1 −1 1 1 −1 −1 −1 −1 −1 −1 −1 −1 −1 −1 −1 −1 1 1 1 1 |
| | 1 1 −1 −1 −1 −1 1 1 −1 −1 1 1 −1 −1 1 1 1 1 1 1 1 1 1 1 1 −1 1 −1 −1 1 −1 1 1 −1 |
| | −1 1 −1 1 1 −1 1 −1 −1 1 1 −1 −1 1 1 −1 1 −1 1 −1 1 −1 1 −1 1 −1 −1 1 −1 1 −1 |
| | 1 1 −1 1 −1 −1 1 1 −1 −1 1 1 −1 −1 1 −1 1 −1 1 −1 1 −1 1 −1 −1 −1 −1 1 1 1 1 |
| | −1 −1 1 1 1 1 −1 −1 −1 −1 1 1 −1 −1 1 1 −1 −1 −1 −1 −1 −1 −1 −1 1 1 1 1 −1 −1 |
| | −1 −1 −1 −1 1 1 1 1 −1 −1 1 1 −1 −1 1 1 −1 −1 −1 −1 −1 −1 −1 −1 −1 −1 1 −1 1 |
| | −1 −1 1 −1 1 1 −1 −1 1 −1 1 1 −1 1 −1 −1 1 1 −1 −1 1 1 −1 1 −1 1 −1 1 −1 −1 1 |
| | −1 1 1 −1 1 −1 1 −1 −1 1 −1 1 1 −1 −1 1 1 −1 −1 1 1 −1 1 −1 1 −1 1 −1 1 −1 1 1 |
| | 1 1 −1 −1 −1 −1 1 1 −1 −1 −1 −1 1 1 1 1 −1 −1 1 1 −1 −1 1 1 1 1 1 1 1 1 1 1 1 1 |
| | −1 −1 −1 −1 −1 −1 1 1 1 1 −1 −1 1 1 −1 −1 1 1 −1 −1 −1 −1 −1 −1 −1 −1 −1 −1 |
| | −1 1 −1 1 1 −1 1 −1 −1 1 1 −1 1 −1 −1 1 −1 1 1 −1 −1 1 1 −1 −1 1 −1 1 −1 1 −1 |
| | 1 −1 1 −1 1 1 −1 1 −1 1 −1 −1 1 −1 1 1 −1 −1 1 1 −1 −1 1 1 −1 1 −1 1 −1 1 −1 1 |
| | −1 −1 −1 −1 −1 1 1 1 1 −1 −1 1 1 1 1 −1 −1 −1 −1 1 1 −1 −1 1 1 −1 −1 −1 −1 −1 |
| | −1 −1 −1 1 1 1 1 −1 −1 −1 −1 −1 −1 1 1 1 1 −1 −1 1 1 −1 −1 1 1 −1 −1 −1 −1 −1 |
| | −1 −1 −1 −1 −1 1 −1 1 −1 −1 1 −1 1 1 −1 −1 1 −1 1 1 −1 1 −1 −1 1 1 −1 −1 1 1 |
| | −1 1 −1 1 −1 1 −1 −1 1 −1 1 1 −1 1 −1 1 −1 −1 1 −1 1 1 −1 −1 1 1 −1 −1 1 1 −1 |
| | 1 −1 1 −1 1 −1 1 −1 −1 −1 −1 −1 −1 −1 −1 −1 −1 −1 1 1 −1 −1 1 1 −1 −1 1 1 1 1 |
| | −1 −1 −1 −1 −1 −1 1 1 1 1 −1 −1 −1 −1 −1 −1 −1 −1 1 1 −1 −1 1 1 −1 −1 −1 −1 |
| | 1 1 1 1 −1 −1 1 1 1 1 −1 −1 −1 −1 −1 1 −1 1 −1 1 −1 1 −1 1 1 −1 −1 1 1 −1 −1 1 |
| | 1 −1 1 −1 −1 1 −1 1 −1 1 1 −1 1 −1 −1 1 −1 1 −1 1 −1 1 1 −1 −1 1 1 −1 −1 1 −1 |
| | 1 1 −1 1 −1 −1 1 1 −1 1 −1 −1 1 −1 1 −1 −1 −1 −1 −1 −1 −1 −1 −1 −1 1 1 −1 −1 |
| | 1 1 −1 −1 1 1 1 1 −1 −1 −1 −1 −1 −1 1 1 1 1 1 1 1 1 1 1 1 1 −1 −1 1 1 −1 −1 1 1 |
| | 1 1 −1 −1 −1 −1 1 1 −1 −1 −1 −1 1 1 1 1 −1 1 −1 1 −1 1 −1 1 −1 1 1 −1 −1 1 1 |
| | −1 −1 1 1 −1 1 −1 −1 1 −1 1 −1 1 1 −1 1 −1 1 −1 1 −1 1 −1 1 −1 −1 1 1 −1 −1 1 |
| | 1 −1 1 −1 −1 1 −1 1 1 −1 −1 1 −1 1 1 −1 1 −1 −1 −1 −1 −1 −1 −1 −1 −1 −1 −1 1 |
| | 1 −1 −1 1 1 −1 −1 1 1 1 1 −1 −1 −1 −1 −1 −1 1 1 1 1 −1 −1 −1 −1 −1 −1 −1 −1 1 |
| | 1 −1 −1 1 1 −1 −1 −1 −1 1 1 1 1 −1 −1 1 1 1 1 −1 −1 −1 −1 −1 1 −1 1 −1 1 −1 1 |
| | −1 1 1 −1 −1 1 1 −1 −1 1 1 −1 1 −1 −1 1 −1 1 −1 1 1 −1 1 −1 −1 1 −1 1 −1 1 −1 |
| | 1 1 −1 −1 1 1 −1 −1 1 −1 1 1 −1 1 −1 −1 1 1 −1 1 −1 −1 1 −1 1 1 1 1 1 1 1 1 1 1 |
| | 1 −1 −1 1 1 −1 −1 1 1 −1 −1 −1 −1 1 1 1 1 1 1 −1 −1 −1 −1 −1 −1 −1 −1 −1 −1 |
| | −1 −1 1 1 −1 −1 1 1 −1 −1 −1 −1 1 1 1 1 −1 −1 1 1 1 1 −1 −1 −1 −1 1 −1 1 −1 1 |
| | −1 1 −1 1 −1 −1 1 1 −1 −1 1 1 −1 −1 1 −1 1 1 −1 1 −1 1 −1 −1 1 −1 1 −1 1 −1 1 |
| | −1 1 −1 1 1 −1 −1 1 1 −1 −1 1 −1 1 1 −1 1 −1 −1 1 1 −1 1 −1 −1 1 −1 1 −1 −1 −1 |
| | −1 −1 −1 −1 −1 −1 −1 1 1 −1 −1 1 1 −1 −1 1 1 1 1 −1 −1 −1 −1 −1 −1 1 1 1 1 −1 |
| | −1 −1 −1 −1 −1 −1 −1 1 1 −1 −1 1 1 −1 −1 −1 −1 1 1 1 1 −1 −1 1 1 1 1 −1 −1 −1 |
| | −1 −1 1 −1 1 −1 1 −1 1 −1 1 1 −1 −1 1 1 −1 −1 1 1 −1 1 −1 −1 1 −1 1 −1 1 1 −1 |
| | 1 −1 −1 1 −1 1 −1 1 −1 1 1 −1 −1 1 1 −1 −1 1 −1 1 1 −1 1 −1 −1 1 1 −1 1 −1 −1 |
| | 1 −1 1 −1 −1 −1 −1 −1 −1 −1 −1 −1 −1 1 1 −1 −1 1 1 −1 −1 1 1 1 1 −1 −1 −1 −1 |
| | −1 −1 1 1 1 1 1 1 1 1 1 1 1 1 −1 −1 1 1 −1 −1 1 1 1 1 −1 −1 −1 −1 1 1 −1 −1 −1 |
| | −1 1 1 1 1 −1 1 −1 1 −1 1 −1 1 −1 1 1 −1 −1 1 1 −1 −1 1 1 −1 1 −1 −1 1 −1 1 −1 |
| | 1 1 −1 1 −1 1 −1 1 −1 1 −1 1 −1 −1 1 1 −1 −1 1 1 −1 1 −1 −1 1 −1 1 1 −1 −1 1 |
| | −1 1 1 −1 1 −1 1 1 1 1 1 1 1 1 1 1 −1 −1 1 1 −1 −1 1 1 −1 −1 −1 −1 1 1 1 1 1 1 |
| | −1 −1 −1 −1 1 1 1 1 1 1 1 1 −1 −1 1 1 −1 −1 1 1 1 1 −1 −1 −1 −1 1 1 −1 −1 −1 |
| | −1 1 1 1 1 1 −1 1 −1 1 −1 1 −1 1 −1 −1 1 1 −1 −1 1 1 −1 −1 1 −1 1 1 −1 1 −1 1 |
| | −1 −1 1 −1 1 1 −1 1 −1 1 −1 1 −1 −1 1 1 −1 −1 1 1 −1 1 −1 −1 1 −1 1 1 −1 −1 1 |
| | −1 1 1 −1 1 −1 −1 −1 −1 −1 −1 −1 −1 −1 −1 −1 1 1 −1 −1 1 1 −1 −1 1 1 1 1 −1 |
| | −1 −1 −1 −1 −1 1 1 1 1 1 1 1 1 1 1 1 1 −1 −1 1 1 −1 −1 1 1 1 1 −1 −1 −1 −1 1 1 |
| | −1 −1 −1 −1 1 1 1 1 −1 1 −1 1 −1 1 −1 1 −1 1 1 −1 −1 1 1 −1 −1 1 1 −1 1 −1 −1 |
| | 1 −1 1 −1 1 1 −1 1 −1 1 −1 1 −1 1 −1 1 −1 −1 1 1 −1 −1 1 1 −1 1 −1 −1 1 −1 1 1 |
| | −1 −1 1 −1 1 1 −1 1 −1 −1 −1 −1 −1 1 1 1 1 −1 −1 1 1 1 1 −1 −1 −1 −1 1 1 −1 −1 |
| | 1 1 −1 −1 −1 −1 −1 −1 −1 −1 −1 −1 −1 −1 1 1 1 1 1 1 −1 −1 −1 −1 1 1 −1 −1 1 1 |
| | −1 −1 1 1 1 1 1 1 1 1 1 1 1 −1 1 −1 −1 1 −1 1 1 −1 −1 1 −1 1 1 −1 1 −1 −1 1 1 −1 |
| | −1 1 1 −1 1 −1 1 −1 1 −1 1 −1 1 −1 −1 1 −1 1 −1 1 1 −1 1 −1 −1 1 1 −1 −1 1 1 |
| | −1 −1 1 −1 1 −1 1 −1 1 −1 1 −1 −1 −1 −1 1 1 1 1 −1 −1 1 1 1 1 −1 −1 −1 −1 1 1 |
| | −1 −1 1 1 −1 −1 −1 −1 −1 −1 −1 −1 1 1 1 1 −1 −1 −1 −1 −1 −1 1 1 1 1 −1 −1 1 1 |
| | −1 −1 1 1 −1 −1 −1 −1 −1 −1 −1 −1 −1 −1 1 −1 1 −1 −1 1 −1 1 1 −1 −1 1 −1 1 1 |
| | −1 1 −1 −1 1 1 −1 −1 1 1 −1 1 −1 1 −1 1 −1 −1 1 −1 1 1 −1 1 −1 1 −1 −1 1 −1 1 |
| | 1 −1 −1 1 1 −1 −1 1 1 −1 1 −1 1 −1 1 −1 1 −1 −1 −1 −1 −1 1 1 1 1 −1 −1 1 1 1 1 |
| | −1 −1 −1 −1 1 1 −1 −1 1 1 −1 −1 −1 −1 −1 −1 −1 −1 −1 −1 −1 −1 1 1 1 1 1 1 −1 |
| | −1 −1 −1 1 1 −1 −1 1 1 −1 −1 1 1 1 1 1 1 1 1 1 1 1 −1 1 −1 −1 1 −1 1 1 −1 −1 1 |
| | −1 1 1 −1 1 −1 −1 1 1 −1 −1 1 1 −1 1 −1 1 −1 1 −1 1 −1 1 −1 −1 1 −1 1 −1 1 1 |
| | −1 1 −1 −1 1 1 −1 −1 1 1 −1 −1 1 −1 1 −1 1 −1 1 −1 1 1 1 1 1 −1 −1 −1 −1 1 1 |
| | −1 −1 −1 −1 1 1 1 1 −1 −1 1 1 −1 −1 1 1 1 1 1 1 1 1 −1 −1 −1 −1 1 1 1 1 1 1 −1 |
| | −1 −1 −1 1 1 −1 −1 1 1 −1 −1 1 1 1 1 1 1 1 1 1 1 −1 1 −1 1 1 −1 1 −1 −1 1 1 −1 1 |
| | −1 −1 1 −1 1 1 −1 −1 1 1 −1 −1 1 −1 1 −1 1 −1 1 1 −1 1 −1 −1 1 −1 1 −1 1 1 −1 |
| | 1 −1 −1 1 1 −1 −1 1 1 −1 −1 1 −1 1 −1 1 −1 1 −1 1 −1 −1 −1 −1 1 1 1 1 −1 −1 1 |
| | 1 1 1 −1 −1 −1 −1 1 1 −1 −1 1 1 −1 −1 −1 −1 −1 −1 −1 −1 −1 −1 −1 −1 1 1 1 1 1 |
| | 1 −1 −1 −1 −1 1 1 −1 −1 1 1 −1 −1 1 1 1 1 1 1 1 1 1 1 1 −1 1 −1 −1 1 −1 1 1 −1 |
| | −1 1 −1 1 1 −1 1 −1 −1 1 1 −1 −1 1 1 −1 1 −1 1 −1 1 −1 1 −1 1 −1 −1 1 −1 1 −1 |
| | 1 1 −1 1 −1 −1 1 1 −1 −1 1 1 −1 −1 1 −1 1 −1 1 −1 1 −1 1 −1 −1 −1 −1 1 1 1 1 |
| | −1 −1 1 1 1 1 −1 −1 −1 −1 1 1 −1 −1 1 1 −1 −1 −1 −1 −1 −1 −1 −1 1 1 1 1 −1 −1 |
| | −1 −1 −1 −1 1 1 1 1 −1 −1 1 1 −1 −1 1 1 −1 −1 −1 −1 −1 −1 −1 −1 −1 −1 1 −1 1 |
| | −1 −1 1 −1 1 1 −1 −1 1 −1 1 1 −1 1 −1 −1 1 1 −1 −1 1 1 −1 1 −1 1 −1 1 −1 −1 1 |
| | −1 1 1 −1 1 −1 1 −1 −1 1 −1 1 1 −1 −1 1 1 −1 −1 1 1 −1 1 −1 1 −1 1 −1 1 −1 1 1 |
| | 1 1 −1 −1 −1 −1 1 1 −1 −1 −1 −1 1 1 1 1 −1 −1 1 1 −1 −1 1 1 1 1 1 1 1 1 1 1 1 1 |
| | −1 −1 −1 −1 −1 −1 1 1 1 1 −1 −1 1 1 −1 −1 1 1 −1 −1 −1 −1 −1 −1 −1 −1 −1 −1 |
| | −1 1 −1 1 1 −1 1 −1 −1 1 1 −1 1 −1 −1 1 −1 1 1 −1 −1 1 1 −1 −1 1 −1 1 −1 1 −1 |
| | 1 −1 1 −1 1 1 −1 1 −1 1 −1 −1 1 −1 1 1 −1 −1 1 1 −1 −1 1 1 −1 1 −1 1 −1 1 −1 1 |
| | −1 −1 −1 −1 −1 1 1 1 1 −1 −1 1 1 1 1 −1 −1 −1 −1 1 1 −1 −1 1 1 −1 −1 −1 −1 −1 |
| | −1 −1 −1 1 1 1 1 −1 −1 −1 −1 −1 −1 1 1 1 1 −1 −1 1 1 −1 −1 1 1 −1 −1 −1 −1 −1 |
| | −1 −1 −1 −1 −1 1 −1 1 −1 −1 1 −1 1 1 −1 −1 1 −1 1 1 −1 1 −1 −1 1 1 −1 −1 1 1 |
| | −1 1 −1 1 −1 1 −1 −1 1 −1 1 1 −1 1 −1 1 −1 −1 1 −1 1 1 −1 −1 1 1 −1 −1 1 1 −1 |
| | 1 −1 1 −1 1 −1 1 −1 1 1 1 1 1 1 1 1 1 1 −1 −1 1 1 −1 −1 1 1 −1 −1 −1 −1 1 1 1 1 |
| | 1 1 −1 −1 −1 −1 1 1 1 1 1 1 1 1 −1 −1 1 1 −1 −1 1 1 1 1 −1 −1 −1 −1 1 1 −1 −1 |
| | −1 −1 1 1 1 1 1 −1 1 −1 1 −1 1 −1 1 −1 −1 1 1 −1 −1 1 1 −1 −1 1 −1 1 1 −1 1 −1 |
| | 1 −1 −1 1 −1 1 1 −1 1 −1 1 −1 1 −1 −1 1 1 −1 −1 1 1 −1 1 −1 −1 1 −1 1 1 −1 −1 |
| | 1 −1 1 1 −1 1 −1 1 1 1 1 1 1 1 1 1 1 −1 −1 1 1 −1 −1 1 1 −1 −1 −1 −1 1 1 1 1 1 1 |
| | −1 −1 −1 −1 −1 −1 −1 −1 −1 −1 −1 −1 1 1 −1 −1 1 1 −1 −1 −1 −1 1 1 1 1 −1 −1 |
| | 1 1 1 1 −1 −1 −1 −1 1 −1 1 −1 1 −1 1 −1 1 −1 −1 1 1 −1 −1 1 1 −1 −1 1 −1 1 1 |
| | −1 1 −1 1 −1 −1 1 −1 1 −1 1 −1 1 −1 1 −1 1 1 −1 −1 1 1 −1 −1 1 −1 1 1 −1 1 −1 |
| | −1 1 1 −1 1 −1 −1 1 −1 1 1 1 1 1 1 1 1 1 1 1 −1 −1 1 1 −1 −1 1 1 −1 −1 −1 −1 1 1 |
| | 1 1 1 1 −1 −1 −1 −1 1 1 1 1 1 1 1 1 −1 −1 1 1 −1 −1 1 1 1 1 −1 −1 −1 −1 1 1 −1 |
| | −1 −1 −1 1 1 1 1 1 −1 1 −1 1 −1 1 −1 1 −1 −1 1 1 −1 −1 1 1 −1 −1 1 −1 1 1 −1 1 |
| | −1 1 −1 −1 1 −1 1 1 −1 1 −1 1 −1 1 −1 −1 1 1 −1 −1 1 1 −1 1 −1 −1 1 −1 1 1 −1 |
| | −1 1 −1 1 1 −1 1 −1 −1 −1 −1 −1 −1 −1 −1 −1 −1 −1 1 1 −1 −1 1 1 −1 −1 1 1 1 1 |
| | −1 −1 −1 −1 −1 −1 1 1 1 1 1 1 1 1 1 1 1 −1 −1 1 1 −1 −1 1 1 1 1 −1 −1 −1 −1 1 |
| | 1 −1 −1 −1 −1 1 1 1 1 −1 1 −1 1 −1 1 −1 1 −1 1 1 −1 −1 1 1 −1 −1 1 1 −1 1 −1 |
| | −1 1 −1 1 −1 1 1 −1 1 −1 1 −1 1 −1 1 −1 1 −1 −1 1 1 −1 −1 1 1 −1 1 −1 −1 1 −1 |
| | 1 1 −1 −1 1 −1 1 1 −1 1 −1 −1 −1 −1 −1 −1 −1 −1 −1 −1 −1 1 1 −1 −1 1 1 −1 −1 |
| | 1 1 1 1 −1 −1 −1 −1 −1 −1 1 1 1 1 −1 −1 −1 −1 −1 −1 −1 −1 1 1 −1 −1 1 1 −1 −1 |
| | −1 −1 1 1 1 1 −1 −1 1 1 1 1 −1 −1 −1 −1 −1 1 −1 1 −1 1 −1 1 −1 1 1 −1 −1 1 1 |
| | −1 −1 1 1 −1 1 −1 −1 1 −1 1 −1 1 1 −1 1 −1 −1 1 −1 1 −1 1 −1 1 1 −1 −1 1 1 −1 |
| | −1 1 −1 1 1 −1 1 −1 −1 1 1 −1 1 −1 −1 1 −1 1 −1 −1 −1 −1 −1 −1 −1 −1 −1 −1 1 |
| | 1 −1 −1 1 1 −1 −1 1 1 1 1 −1 −1 −1 −1 −1 −1 1 1 1 1 1 1 1 1 1 1 1 1 −1 −1 1 1 −1 |
| | −1 1 1 1 1 −1 −1 −1 −1 1 1 −1 −1 −1 −1 1 1 1 1 −1 1 −1 1 −1 1 −1 1 −1 1 1 −1 |
| | −1 1 1 −1 −1 1 1 −1 1 −1 −1 1 −1 1 −1 1 1 −1 1 −1 1 −1 1 −1 1 −1 1 −1 −1 1 1 |
| | −1 −1 1 1 −1 1 −1 −1 1 −1 1 1 −1 −1 1 −1 1 1 −1 1 −1 1 1 1 1 1 1 1 1 1 1 −1 −1 1 |
| | 1 −1 −1 1 1 −1 −1 −1 −1 1 1 1 1 1 1 −1 −1 −1 −1 1 1 1 1 1 1 1 1 −1 −1 1 1 −1 −1 |
| | 1 1 1 1 −1 −1 −1 −1 1 1 −1 −1 −1 −1 1 1 1 1 1 −1 1 −1 1 −1 1 −1 1 −1 −1 1 1 −1 |
| | −1 1 1 −1 −1 1 −1 1 1 −1 1 −1 1 −1 −1 1 −1 1 1 −1 1 −1 1 −1 1 −1 −1 1 1 −1 −1 |
| | 1 1 −1 1 −1 −1 1 −1 1 1 −1 −1 1 −1 1 1 −1 1 −1 −1 −1 −1 −1 −1 −1 −1 −1 −1 −1 |
| | 1 1 −1 −1 1 1 −1 −1 1 1 1 1 −1 −1 −1 −1 −1 −1 1 1 1 1 1 1 1 1 1 1 1 1 −1 −1 1 1 |
| | −1 −1 1 1 1 1 −1 −1 −1 −1 1 1 −1 −1 −1 −1 1 1 1 1 −1 1 −1 1 −1 1 −1 1 −1 1 1 |
| | −1 −1 1 1 −1 −1 1 1 −1 1 −1 −1 1 −1 1 −1 1 1 −1 1 −1 1 −1 1 −1 1 −1 1 −1 −1 1 |
| | 1 −1 −1 1 1 −1 1 −1 −1 1 −1 1 1 −1 −1 1 −1 1 1 −1 1 −1 1 1 1 1 −1 −1 −1 −1 1 1 |
| | −1 −1 −1 −1 1 1 1 1 −1 −1 1 1 −1 −1 1 1 1 1 1 1 1 1 1 1 1 1 −1 −1 −1 −1 −1 −1 1 |
| | 1 1 1 −1 −1 1 −1 −1 1 1 −1 −1 −1 −1 −1 −1 −1 −1 −1 −1 −1 1 −1 1 1 −1 1 −1 |
| | −1 1 1 −1 1 −1 −1 1 −1 1 1 −1 −1 1 1 −1 −1 1 −1 1 −1 1 −1 1 −1 1 −1 1 1 −1 1 |
| | −1 1 −1 −1 1 −1 1 1 −1 −1 1 1 −1 −1 1 1 −1 1 −1 1 −1 1 −1 1 −1 1 1 1 1 −1 −1 |
| | −1 −1 1 1 −1 −1 −1 −1 1 1 1 1 −1 −1 1 1 −1 −1 1 1 1 1 1 −1 −1 −1 −1 1 1 1 |
| | 1 1 1 −1 −1 −1 −1 1 1 −1 −1 1 1 −1 −1 1 1 1 1 1 1 1 1 1 1 −1 1 −1 1 1 −1 1 −1 −1 |
| | 1 1 −1 1 −1 −1 1 −1 1 1 −1 −1 1 1 −1 −1 1 −1 1 −1 1 −1 1 1 −1 1 −1 −1 1 −1 1 |
| | −1 1 1 −1 1 −1 −1 1 1 −1 −1 1 1 −1 −1 1 −1 1 −1 1 −1 1 1 1 1 −1 −1 −1 |
| | −1 1 1 −1 −1 −1 −1 1 1 1 1 −1 −1 1 1 −1 −1 1 1 1 1 1 1 1 1 1 1 1 1 −1 −1 −1 −1 |
| | −1 −1 1 1 1 1 −1 −1 1 1 −1 −1 1 1 −1 −1 −1 −1 −1 −1 −1 −1 −1 −1 −1 1 −1 1 1 |
| | −1 1 −1 −1 1 1 −1 1 −1 −1 1 −1 1 1 −1 −1 1 1 −1 −1 1 −1 1 −1 1 −1 1 −1 1 −1 1 |
| | 1 −1 1 −1 1 −1 −1 1 −1 1 1 −1 −1 1 1 −1 −1 1 1 −1 1 −1 1 −1 1 −1 1 −1 −1 −1 −1 |
| | −1 1 1 1 1 −1 −1 1 1 1 1 −1 −1 −1 −1 1 1 −1 −1 1 1 −1 −1 −1 −1 −1 −1 −1 −1 1 1 |
| | 1 1 −1 −1 −1 −1 −1 −1 1 1 1 1 −1 −1 1 1 −1 −1 1 1 −1 −1 −1 −1 −1 −1 −1 −1 −1 |
| | −1 1 −1 1 −1 −1 1 −1 1 1 −1 −1 1 1 1 1 −1 1 −1 −1 1 1 −1 −1 1 1 −1 1 −1 1 −1 |
| | 1 −1 −1 1 −1 1 1 −1 1 −1 1 −1 −1 1 −1 1 1 −1 −1 1 1 −1 −1 1 1 −1 1 −1 1 −1 1 |
| | −1 1 −1 −1 −1 −1 1 1 1 1 −1 −1 1 1 1 1 −1 −1 −1 −1 1 1 −1 −1 1 1 −1 −1 −1 |
| | −1 −1 −1 −1 −1 −1 −1 −1 −1 1 1 1 1 1 1 −1 −1 −1 −1 1 1 −1 −1 1 1 −1 −1 1 1 1 1 |
| | 1 1 1 1 1 1 1 −1 1 −1 −1 1 −1 1 1 −1 −1 1 −1 1 1 −1 1 −1 −1 1 1 −1 −1 1 1 −1 1 |
| | −1 1 −1 1 −1 1 −1 1 −1 −1 1 −1 1 −1 1 1 −1 1 −1 −1 1 1 −1 −1 1 1 −1 −1 1 −1 1 |
| | −1 1 −1 1 −1 1 −1 −1 −1 −1 1 1 1 1 −1 −1 1 1 1 1 −1 −1 −1 −1 1 1 −1 −1 1 1 −1 |
| | −1 −1 −1 −1 −1 −1 −1 1 1 1 1 −1 −1 −1 −1 −1 −1 1 1 1 1 −1 −1 1 1 −1 −1 1 1 −1 |
| | −1 −1 −1 −1 −1 −1 −1 −1 −1 1 −1 1 −1 −1 1 −1 1 1 −1 −1 1 −1 1 1 −1 1 −1 −1 1 |
| | 1 −1 −1 1 1 −1 1 −1 1 −1 1 −1 −1 1 −1 1 1 −1 1 −1 1 −1 −1 1 −1 1 1 −1 −1 1 1 |
| | −1 −1 1 1 −1 1 −1 1 −1 1 −1 1 −1 1 1 1 1 −1 −1 −1 −1 1 1 −1 −1 −1 −1 1 1 1 1 |
| | −1 −1 1 1 −1 −1 1 1 1 1 1 1 1 1 1 1 1 1 −1 −1 −1 −1 −1 −1 1 1 1 1 −1 −1 1 1 −1 |
| | −1 1 1 −1 −1 −1 −1 −1 −1 −1 −1 −1 −1 −1 1 −1 1 1 −1 1 −1 −1 1 1 −1 1 −1 −1 1 |
| | −1 1 1 −1 −1 1 1 −1 −1 1 −1 1 −1 1 −1 1 −1 1 −1 1 1 −1 1 −1 1 −1 −1 1 −1 1 1 |
| | −1 −1 1 1 −1 −1 1 1 −1 1 −1 1 −1 1 −1 1 −1 −1 −1 −1 −1 1 1 1 1 −1 −1 1 1 1 1 |
| | −1 −1 −1 −1 1 1 −1 −1 1 1 −1 −1 −1 −1 −1 −1 −1 −1 1 1 1 1 −1 −1 −1 −1 −1 −1 |
| | 1 1 1 1 −1 −1 1 1 −1 −1 1 1 −1 −1 −1 −1 −1 −1 −1 −1 −1 −1 1 −1 1 −1 −1 1 −1 1 |
| | 1 −1 −1 1 −1 1 1 −1 1 −1 −1 1 1 −1 −1 1 1 −1 1 −1 1 −1 1 −1 −1 1 −1 1 1 −1 1 |
| | −1 1 −1 −1 1 −1 1 1 −1 −1 1 1 −1 −1 1 1 −1 1 −1 1 −1 1 −1 1 −1 |
| 7 | 1 1 1 1 1 −1 1 −1 1 1 1 1 −1 1 −1 1 1 −1 1 −1 1 1 1 1 1 −1 1 −1 −1 −1 −1 −1 1 1 |
| | −1 −1 1 −1 −1 1 −1 −1 1 1 1 −1 −1 1 1 −1 −1 1 1 1 −1 −1 −1 1 1 −1 1 1 −1 −1 1 |
| | 1 1 1 1 −1 1 −1 1 1 1 1 −1 1 −1 1 1 −1 1 −1 1 1 1 1 1 −1 1 −1 −1 −1 −1 −1 1 1 −1 |
| | −1 1 −1 −1 1 −1 −1 1 1 1 −1 −1 1 1 −1 −1 1 1 1 −1 −1 −1 1 1 −1 1 1 −1 −1 1 1 1 |
| | 1 1 −1 1 −1 1 1 1 1 −1 1 −1 1 1 −1 1 −1 1 1 1 1 1 −1 1 −1 −1 −1 −1 −1 1 1 −1 −1 |
| | 1 −1 −1 1 −1 −1 1 1 1 −1 −1 1 1 −1 −1 1 1 1 −1 −1 −1 1 1 −1 1 1 −1 −1 −1 −1 −1 |
| | −1 −1 1 −1 1 −1 −1 −1 −1 1 −1 1 −1 −1 1 −1 1 −1 −1 −1 −1 −1 1 −1 1 1 1 1 1 −1 |
| | −1 1 1 −1 1 1 −1 1 1 −1 −1 −1 1 1 −1 −1 1 1 −1 −1 −1 1 1 1 −1 −1 1 −1 −1 1 1 1 |
| | 1 −1 −1 1 −1 −1 1 1 1 −1 −1 −1 1 1 −1 1 −1 −1 1 1 1 −1 −1 1 −1 −1 1 −1 −1 1 1 |
| | 1 1 1 1 1 −1 1 −1 −1 −1 −1 −1 1 −1 1 −1 1 −1 1 −1 1 1 1 1 −1 1 −1 1 1 1 1 1 1 |
| | −1 −1 1 −1 −1 1 1 1 −1 −1 −1 1 1 −1 1 −1 −1 1 1 1 −1 −1 1 −1 −1 1 −1 −1 1 1 1 |
| | 1 1 1 1 −1 1 −1 −1 −1 −1 −1 1 −1 1 −1 1 −1 1 −1 1 1 1 1 −1 1 −1 1 1 1 1 1 1 1 −1 |
| | −1 1 −1 −1 1 1 1 −1 −1 −1 1 1 −1 1 −1 −1 1 1 1 −1 −1 1 −1 −1 1 −1 −1 1 1 1 1 1 |
| | 1 1 −1 1 −1 −1 −1 −1 −1 1 −1 1 −1 1 −1 1 −1 1 1 1 1 −1 1 −1 1 1 1 1 1 −1 −1 1 1 |
| | −1 1 1 −1 −1 −1 1 1 1 −1 −1 1 −1 1 1 −1 −1 −1 1 1 −1 1 1 −1 1 1 −1 −1 −1 −1 −1 |
| | −1 −1 1 −1 1 1 1 1 1 −1 1 −1 1 −1 1 −1 1 −1 −1 −1 −1 1 −1 1 −1 −1 −1 −1 −1 1 1 |
| | 1 1 1 −1 1 −1 1 1 1 1 −1 1 −1 1 1 −1 1 −1 1 1 1 1 1 −1 1 −1 −1 −1 −1 −1 1 1 −1 |
| | −1 1 −1 −1 1 −1 −1 1 1 1 −1 −1 1 1 −1 −1 1 1 1 −1 −1 −1 1 1 −1 1 1 −1 −1 1 1 1 |
| | 1 1 −1 1 −1 1 1 1 1 −1 1 −1 1 1 −1 1 −1 1 1 1 1 1 −1 1 −1 −1 −1 −1 −1 1 1 −1 −1 |
| | 1 −1 −1 1 −1 −1 1 1 1 −1 −1 1 1 −1 −1 1 1 1 −1 −1 −1 1 1 −1 1 1 −1 −1 −1 −1 −1 |
| | −1 −1 1 −1 1 −1 −1 −1 −1 1 −1 1 −1 −1 1 −1 1 −1 −1 −1 −1 −1 1 −1 1 1 1 1 1 −1 |
| | −1 1 1 −1 1 1 −1 1 1 −1 −1 −1 1 1 −1 −1 1 1 −1 −1 −1 1 1 1 −1 −1 1 −1 −1 1 1 1 |
| | 1 1 1 1 −1 1 −1 1 1 1 1 −1 1 −1 1 1 −1 1 −1 1 1 1 1 1 −1 1 −1 −1 −1 −1 −1 1 1 −1 |
| | −1 1 −1 −1 1 −1 −1 1 1 1 −1 −1 1 1 −1 −1 1 1 1 −1 −1 −1 1 1 −1 1 1 −1 −1 1 1 |
| | −1 −1 1 −1 −1 1 1 1 −1 −1 −1 1 1 −1 1 −1 −1 1 1 1 −1 −1 1 −1 −1 1 −1 −1 1 1 1 |
| | 1 1 1 1 −1 1 −1 −1 −1 −1 −1 1 −1 1 −1 1 −1 1 −1 1 1 1 1 −1 1 −1 1 1 1 1 1 1 1 −1 |
| | −1 1 −1 −1 1 1 1 −1 −1 −1 1 1 −1 1 −1 −1 1 1 1 −1 −1 1 −1 −1 1 −1 −1 1 1 1 1 1 |
| | 1 1 −1 1 −1 −1 −1 −1 −1 1 −1 1 −1 1 −1 1 −1 1 1 1 1 −1 1 −1 1 1 1 1 1 −1 −1 1 1 |
| | −1 1 1 −1 −1 −1 1 1 1 −1 −1 1 −1 1 1 −1 −1 −1 1 1 −1 1 1 −1 1 1 −1 −1 −1 −1 −1 |
| | −1 −1 1 −1 1 1 1 1 1 −1 1 −1 1 −1 1 −1 1 −1 −1 −1 −1 1 −1 1 −1 −1 −1 −1 −1 1 1 |
| | −1 −1 1 −1 −1 1 1 1 −1 −1 −1 1 1 −1 1 −1 −1 1 1 1 −1 −1 1 −1 −1 1 −1 −1 1 1 1 |
| | 1 1 1 1 −1 1 −1 −1 −1 −1 −1 1 −1 1 −1 1 −1 1 −1 1 1 1 1 −1 1 −1 1 1 1 1 1 1 1 1 |
| | 1 1 −1 1 −1 1 1 1 1 −1 1 −1 1 1 −1 1 −1 1 1 1 1 1 −1 1 −1 −1 −1 −1 −1 1 1 −1 −1 |
| | 1 −1 −1 1 −1 −1 1 1 1 −1 −1 1 1 −1 −1 1 1 1 −1 −1 −1 1 1 −1 1 1 −1 −1 −1 −1 −1 |
| | −1 −1 1 −1 1 −1 −1 −1 −1 1 −1 1 −1 −1 1 −1 1 −1 −1 −1 −1 −1 1 −1 1 1 1 1 1 −1 |
| | −1 1 1 −1 1 1 −1 1 1 −1 −1 −1 1 1 −1 −1 1 1 −1 −1 −1 1 1 1 −1 −1 1 −1 −1 1 1 1 |
| | 1 1 1 1 −1 1 −1 1 1 1 1 −1 1 −1 1 1 −1 1 −1 1 1 1 1 1 −1 1 −1 −1 −1 −1 −1 1 1 −1 |
| | −1 1 −1 −1 1 −1 −1 1 1 1 −1 −1 1 1 −1 −1 1 1 1 −1 −1 −1 1 1 −1 1 1 −1 −1 1 1 1 |
| | 1 1 −1 1 −1 1 1 1 1 −1 1 −1 1 1 −1 1 −1 1 1 1 1 1 −1 1 −1 −1 −1 −1 −1 1 1 −1 −1 |
| | 1 −1 −1 1 −1 −1 1 1 1 −1 −1 1 1 −1 −1 1 1 1 −1 −1 −1 1 1 −1 1 1 −1 −1 −1 −1 1 |
| | 1 −1 1 1 −1 −1 −1 1 1 1 −1 −1 1 −1 1 1 −1 −1 −1 1 1 −1 1 1 −1 1 1 −1 −1 −1 −1 |
| | −1 −1 −1 1 −1 1 1 1 1 1 −1 1 −1 1 −1 1 −1 1 −1 −1 −1 −1 1 −1 1 −1 −1 −1 −1 −1 |
| | 1 1 −1 −1 1 −1 −1 1 1 1 −1 −1 −1 1 1 −1 1 −1 −1 1 1 1 −1 −1 1 −1 −1 1 −1 −1 1 |
| | 1 1 1 1 1 1 −1 1 −1 −1 −1 −1 −1 1 −1 1 −1 1 −1 1 −1 1 1 1 1 −1 1 −1 1 1 1 1 1 −1 |
| | −1 1 1 −1 1 1 −1 −1 −1 1 1 1 −1 −1 1 −1 1 1 −1 −1 −1 1 1 −1 1 1 −1 1 1 −1 −1 |
| | −1 −1 −1 −1 −1 1 −1 1 1 1 1 1 −1 1 −1 1 −1 1 −1 1 −1 −1 −1 −1 1 −1 1 −1 −1 −1 |
| | −1 −1 −1 −1 1 1 −1 1 1 −1 −1 −1 1 1 1 −1 −1 1 −1 1 1 −1 −1 −1 1 1 −1 1 1 −1 1 |
| | 1 −1 −1 −1 −1 −1 −1 −1 1 −1 1 1 1 1 1 −1 1 −1 1 −1 1 −1 1 −1 −1 −1 −1 1 −1 1 |
| | −1 −1 −1 −1 −1 1 1 1 1 1 −1 1 −1 1 1 1 1 −1 1 −1 1 1 −1 1 −1 1 1 1 1 1 −1 1 −1 |
| | −1 −1 −1 −1 1 1 −1 −1 1 −1 −1 1 −1 −1 1 1 1 −1 −1 1 1 −1 −1 1 1 1 −1 −1 −1 1 1 |
| | −1 1 1 −1 −1 −1 −1 −1 −1 −1 1 −1 1 −1 −1 −1 −1 1 −1 1 −1 −1 1 −1 1 −1 −1 −1 |
| | −1 −1 1 −1 1 1 1 1 1 −1 −1 1 1 −1 1 1 −1 1 1 −1 −1 −1 1 1 −1 −1 1 1 −1 −1 −1 1 |
| | 1 1 −1 −1 1 −1 −1 1 1 −1 −1 −1 −1 −1 1 −1 1 −1 −1 −1 −1 1 −1 1 −1 −1 1 −1 1 |
| | −1 −1 −1 −1 −1 1 −1 1 1 1 1 1 −1 −1 1 1 −1 1 1 −1 1 1 −1 −1 −1 1 1 −1 −1 1 1 |
| | −1 −1 −1 1 1 1 −1 −1 1 −1 −1 1 1 −1 −1 −1 −1 −1 1 −1 1 −1 −1 −1 −1 1 −1 1 −1 |
| | −1 1 −1 1 −1 −1 −1 −1 −1 1 −1 1 1 1 1 1 −1 −1 1 1 −1 1 1 −1 1 1 −1 −1 −1 1 1 |
| | −1 −1 1 1 −1 −1 −1 1 1 1 −1 −1 1 −1 −1 1 1 −1 −1 1 1 −1 1 1 −1 −1 −1 1 1 1 −1 |
| | −1 1 −1 1 1 −1 −1 −1 1 1 −1 1 1 −1 1 1 −1 −1 −1 −1 −1 −1 −1 1 −1 1 1 1 1 1 −1 |
| | 1 −1 1 −1 1 −1 1 −1 −1 −1 −1 1 −1 1 −1 −1 −1 −1 −1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 1 1 1 1 1 −1 1 −1 1 1 1 1 −1 |
| | 1 −1 1 1 −1 1 −1 1 1 1 1 1 −1 1 −1 −1 −1 −1 −1 1 1 −1 −1 1 −1 −1 1 −1 −1 1 1 1 |
| | −1 −1 1 1 −1 −1 1 1 1 −1 −1 −1 1 1 −1 1 1 −1 −1 1 1 1 1 1 −1 1 −1 1 1 1 1 −1 1 |
| | −1 1 1 −1 1 −1 1 1 1 1 1 −1 1 −1 −1 −1 −1 −1 1 1 −1 −1 1 −1 −1 1 −1 −1 1 1 1 |
| | −1 −1 1 1 −1 −1 1 1 1 −1 −1 −1 1 1 −1 1 1 −1 −1 1 1 1 1 1 −1 1 −1 1 1 1 1 −1 1 |
| | −1 1 1 −1 1 −1 1 1 1 1 1 −1 1 −1 −1 −1 −1 −1 1 1 −1 −1 1 −1 −1 1 −1 −1 1 1 1 |
| | −1 −1 1 1 −1 −1 1 1 1 −1 −1 −1 1 1 −1 1 1 −1 −1 −1 −1 −1 −1 −1 1 −1 1 −1 −1 |
| | −1 −1 1 −1 1 −1 −1 1 −1 1 −1 −1 −1 −1 −1 1 −1 1 1 1 1 1 −1 −1 1 1 −1 1 1 −1 1 |
| | 1 −1 −1 −1 1 1 −1 −1 1 1 −1 −1 −1 1 1 1 −1 −1 1 −1 −1 1 1 1 1 −1 −1 1 −1 −1 1 |
| | 1 1 −1 −1 −1 1 1 −1 1 −1 −1 1 1 1 −1 −1 1 −1 −1 1 −1 −1 1 1 1 1 1 1 1 −1 1 −1 |
| | −1 −1 −1 −1 1 −1 1 −1 1 −1 1 −1 1 1 1 1 −1 1 −1 1 1 1 1 1 1 1 −1 −1 1 −1 −1 1 1 |
| | 1 −1 −1 −1 1 1 −1 1 −1 −1 1 1 1 −1 −1 1 −1 −1 1 −1 −1 1 1 1 1 1 1 1 −1 1 −1 −1 |
| | −1 −1 −1 1 −1 1 −1 1 −1 1 −1 1 1 1 1 −1 1 −1 1 1 1 1 1 1 1 −1 −1 1 −1 −1 1 1 1 |
| | −1 −1 −1 1 1 −1 1 −1 −1 1 1 1 −1 −1 1 −1 −1 1 −1 −1 1 1 1 1 1 1 1 −1 1 −1 −1 |
| | −1 −1 −1 1 −1 1 −1 1 −1 1 −1 1 1 1 1 −1 1 −1 1 1 1 1 1 −1 −1 1 1 −1 1 1 −1 −1 |
| | −1 1 1 1 −1 −1 1 −1 1 1 −1 −1 −1 1 1 −1 1 1 −1 1 1 −1 −1 −1 −1 −1 −1 −1 1 −1 1 |
| | 1 1 1 1 −1 1 −1 1 −1 1 −1 1 −1 −1 −1 −1 1 −1 1 −1 −1 −1 −1 −1 −1 −1 −1 −1 −1 |
| | 1 −1 1 −1 −1 −1 −1 1 −1 1 −1 −1 1 −1 1 −1 −1 −1 −1 −1 1 −1 1 1 1 1 1 −1 −1 1 1 |
| | −1 1 1 −1 1 1 −1 −1 −1 1 1 −1 −1 1 1 −1 −1 −1 1 1 1 −1 −1 1 −1 −1 1 1 −1 −1 −1 |
| | −1 −1 1 −1 1 −1 −1 −1 −1 1 −1 1 −1 −1 1 −1 1 −1 −1 −1 −1 −1 1 −1 1 1 1 1 1 −1 |
| | −1 1 1 −1 1 1 −1 1 1 −1 −1 −1 1 1 −1 −1 1 1 −1 −1 −1 1 1 1 −1 −1 1 −1 −1 1 1 1 |
| | 1 1 1 1 −1 1 −1 1 1 1 1 −1 1 −1 1 1 −1 1 −1 1 1 1 1 1 −1 1 −1 −1 −1 −1 −1 1 1 −1 |
| | −1 1 −1 −1 1 −1 −1 1 1 1 −1 −1 1 1 −1 −1 1 1 1 −1 −1 −1 1 1 −1 1 1 −1 −1 −1 −1 |
| | −1 −1 −1 1 −1 1 −1 −1 −1 −1 1 −1 1 −1 −1 1 −1 1 −1 −1 −1 −1 −1 1 −1 1 1 1 1 1 |
| | −1 −1 1 1 −1 1 1 −1 1 1 −1 −1 −1 1 1 −1 −1 1 1 −1 −1 −1 1 1 1 −1 −1 1 −1 −1 1 |
| | 1 −1 −1 1 1 −1 1 1 −1 −1 −1 1 1 1 −1 −1 1 −1 1 1 −1 −1 −1 1 1 −1 1 1 1 1 −1 |
| | −1 −1 −1 −1 −1 −1 1 −1 1 1 1 1 1 −1 1 −1 1 −1 1 −1 1 −1 −1 −1 −1 1 −1 1 −1 −1 |
| | −1 −1 −1 −1 −1 1 1 −1 1 1 −1 −1 −1 1 1 1 −1 −1 1 −1 1 1 −1 −1 −1 1 1 −1 1 1 −1 |
| | 1 1 −1 −1 −1 −1 −1 −1 −1 1 −1 1 1 1 1 1 −1 1 −1 1 −1 1 −1 1 −1 −1 −1 1 −1 1 |
| | −1 −1 −1 −1 −1 1 1 −1 −1 1 −1 −1 1 1 1 −1 −1 −1 1 1 −1 1 −1 −1 1 1 1 −1 −1 1 |
| | −1 −1 1 −1 −1 1 1 1 1 1 1 1 −1 1 −1 −1 −1 −1 −1 1 −1 1 −1 1 −1 1 −1 1 1 1 1 −1 |
| | 1 −1 1 1 1 1 1 −1 −1 1 1 −1 1 1 −1 −1 −1 1 1 1 −1 −1 1 −1 1 1 −1 −1 −1 1 1 −1 1 |
| | 1 −1 1 1 −1 −1 −1 −1 −1 −1 −1 1 −1 1 1 1 1 1 −1 1 −1 1 −1 1 −1 1 −1 −1 −1 −1 1 |
| | −1 1 −1 −1 −1 −1 −1 1 1 1 1 1 −1 1 −1 1 1 1 1 −1 1 −1 1 1 −1 1 −1 1 1 1 1 1 −1 1 |
| | −1 −1 −1 −1 −1 1 1 −1 −1 1 −1 −1 1 −1 −1 1 1 1 −1 −1 1 1 −1 −1 1 1 1 −1 −1 −1 |
| | 1 1 −1 1 1 −1 −1 −1 −1 −1 −1 −1 1 −1 1 −1 −1 −1 −1 1 −1 1 −1 −1 1 −1 1 −1 −1 |
| | −1 −1 −1 1 −1 1 1 1 1 1 −1 −1 1 1 −1 1 1 −1 1 1 −1 −1 −1 1 1 −1 −1 1 1 −1 −1 |
| | −1 1 1 1 −1 −1 1 −1 −1 1 1 1 1 1 1 1 −1 1 −1 1 1 1 1 −1 1 −1 1 1 −1 1 −1 1 1 1 1 |
| | 1 −1 1 −1 −1 −1 −1 −1 1 1 −1 −1 1 −1 −1 1 −1 −1 1 1 1 −1 −1 1 1 −1 −1 1 1 1 −1 |
| | −1 −1 1 1 −1 1 1 −1 −1 1 1 1 1 1 −1 1 −1 1 1 1 1 −1 1 −1 1 1 −1 1 −1 1 1 1 1 1 |
| | −1 1 −1 −1 −1 −1 −1 1 1 −1 −1 1 −1 −1 1 −1 −1 1 1 1 −1 −1 1 1 −1 −1 1 1 1 −1 |
| | −1 −1 1 1 −1 1 1 −1 −1 −1 −1 1 1 −1 1 1 −1 −1 −1 1 1 1 −1 −1 1 −1 1 1 −1 −1 −1 |
| | 1 1 −1 1 1 −1 1 1 −1 −1 −1 −1 −1 −1 −1 1 −1 1 1 1 1 1 −1 1 −1 1 −1 1 −1 1 −1 |
| | −1 −1 −1 1 −1 1 −1 −1 −1 −1 −1 1 1 −1 −1 1 −1 −1 1 1 1 −1 −1 −1 1 1 −1 1 −1 |
| | −1 1 1 1 −1 −1 1 −1 −1 1 −1 −1 1 1 1 1 1 1 1 −1 1 −1 −1 −1 −1 −1 1 −1 1 −1 1 |
| | −1 1 −1 1 1 1 1 −1 1 −1 1 1 1 1 1 −1 −1 1 1 −1 1 1 −1 −1 −1 1 1 1 −1 −1 1 −1 1 1 |
| | −1 −1 −1 1 1 −1 1 1 −1 1 1 −1 −1 −1 −1 −1 −1 −1 1 −1 1 1 1 1 1 −1 1 −1 1 −1 1 |
| | −1 1 −1 −1 −1 −1 1 −1 1 −1 −1 −1 −1 −1 −1 −1 1 1 −1 1 1 −1 −1 −1 1 1 1 −1 −1 |
| | 1 −1 1 1 −1 −1 −1 1 1 −1 1 1 −1 1 1 −1 −1 −1 −1 −1 −1 −1 1 −1 1 1 1 1 1 −1 1 |
| | −1 1 −1 1 −1 1 −1 −1 −1 −1 1 −1 1 −1 −1 −1 −1 −1 −1 −1 −1 −1 −1 1 −1 1 −1 −1 |
| | −1 −1 1 −1 1 −1 −1 1 −1 1 −1 −1 −1 −1 −1 1 −1 1 1 1 1 1 −1 −1 1 1 −1 1 1 −1 1 |
| | 1 −1 −1 −1 1 1 −1 −1 1 1 −1 −1 −1 1 1 1 −1 −1 1 −1 −1 1 1 1 1 1 1 1 −1 1 −1 1 1 |
| | 1 1 −1 1 −1 1 1 −1 1 −1 1 1 1 1 1 −1 1 −1 −1 −1 −1 −1 1 1 −1 −1 1 −1 −1 1 −1 |
| | −1 1 1 1 −1 −1 1 1 −1 −1 1 1 1 −1 −1 −1 1 1 −1 1 1 −1 −1 1 1 1 1 1 −1 1 −1 1 1 1 |
| | 1 −1 1 −1 1 1 −1 1 −1 1 1 1 1 1 −1 1 −1 −1 −1 −1 −1 1 1 −1 −1 1 −1 −1 1 −1 −1 |
| | 1 1 1 −1 −1 1 1 −1 −1 1 1 1 −1 −1 −1 1 1 −1 1 1 −1 −1 1 1 1 1 1 −1 1 −1 1 1 1 1 |
| | −1 1 −1 1 1 −1 1 −1 1 1 1 1 1 −1 1 −1 −1 −1 −1 −1 1 1 −1 −1 1 −1 −1 1 −1 −1 1 |
| | 1 1 −1 −1 1 1 −1 −1 1 1 1 −1 −1 −1 1 1 −1 1 1 −1 −1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 −1 −1 1 1 −1 1 1 −1 −1 −1 1 |
| | 1 1 −1 −1 1 −1 1 1 −1 −1 −1 1 1 −1 1 1 −1 1 1 −1 −1 −1 −1 −1 −1 −1 1 −1 1 1 1 |
| | 1 1 −1 1 −1 1 −1 1 −1 1 −1 −1 −1 −1 1 −1 1 −1 −1 −1 −1 −1 −1 −1 1 1 −1 1 1 −1 |
| | −1 −1 1 1 1 −1 −1 1 −1 1 1 −1 −1 −1 1 1 −1 1 1 −1 1 1 −1 −1 −1 −1 −1 −1 −1 1 |
| | −1 1 1 1 1 1 −1 1 −1 1 −1 1 −1 1 −1 −1 −1 −1 1 −1 1 −1 −1 −1 −1 −1 −1 −1 1 1 |
| | −1 1 1 −1 −1 −1 1 1 1 −1 −1 1 −1 1 1 −1 −1 −1 1 1 −1 1 1 −1 1 1 −1 −1 −1 −1 −1 |
| | −1 −1 1 −1 1 1 1 1 1 −1 1 −1 1 −1 1 −1 1 −1 −1 −1 −1 1 −1 1 −1 −1 −1 −1 −1 −1 |
| | −1 −1 −1 −1 1 −1 1 −1 −1 −1 −1 1 −1 1 −1 −1 1 −1 1 −1 −1 −1 −1 −1 1 −1 1 1 1 |
| | 1 1 −1 −1 1 1 −1 1 1 −1 1 1 −1 −1 −1 1 1 −1 −1 1 1 −1 −1 −1 1 1 1 −1 −1 1 −1 |
| | −1 1 1 −1 −1 −1 −1 −1 1 −1 1 −1 −1 −1 −1 1 −1 1 −1 −1 1 −1 1 −1 −1 −1 −1 −1 |
| | 1 −1 1 1 1 1 1 −1 −1 1 1 −1 1 1 −1 1 1 −1 −1 −1 1 1 −1 −1 1 1 −1 −1 −1 1 1 1 −1 |
| | −1 1 −1 −1 1 1 −1 −1 −1 −1 −1 1 −1 1 −1 −1 −1 −1 1 −1 1 −1 −1 1 −1 1 −1 −1 |
| | −1 −1 −1 1 −1 1 1 1 1 1 −1 −1 1 1 −1 1 1 −1 1 1 −1 −1 −1 1 1 −1 −1 1 1 −1 −1 |
| | −1 1 1 1 −1 −1 1 −1 −1 1 1 1 1 1 1 1 −1 1 −1 1 1 1 1 −1 1 −1 1 1 −1 1 −1 1 1 1 1 |
| | 1 −1 1 −1 −1 −1 −1 −1 1 1 −1 −1 1 −1 −1 1 −1 −1 1 1 1 −1 −1 1 1 −1 −1 1 1 1 −1 |
| | −1 −1 1 1 −1 1 1 −1 −1 −1 −1 1 1 −1 1 1 −1 −1 −1 1 1 1 −1 −1 1 −1 1 1 −1 −1 −1 |
| | 1 1 −1 1 1 −1 1 1 −1 −1 −1 −1 −1 −1 −1 1 −1 1 1 1 1 1 −1 1 −1 1 −1 1 −1 1 −1 |
| | −1 −1 −1 1 −1 1 −1 −1 −1 −1 −1 −1 −1 1 1 −1 1 1 −1 −1 −1 1 1 1 −1 −1 1 −1 1 1 |
| | −1 −1 −1 1 1 −1 1 1 −1 1 1 −1 −1 −1 −1 −1 −1 −1 1 −1 1 1 1 1 1 −1 1 −1 1 −1 1 |
| | −1 1 −1 −1 −1 −1 1 −1 1 −1 −1 −1 −1 −1 −1 −1 1 1 −1 1 1 −1 −1 −1 1 1 1 −1 −1 |
| | 1 −1 1 1 −1 −1 −1 1 1 −1 1 1 −1 1 1 −1 −1 −1 −1 −1 −1 −1 1 −1 1 1 1 1 1 −1 1 |
| | −1 1 −1 1 −1 1 −1 −1 −1 −1 1 −1 1 −1 −1 −1 −1 −1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 −1 −1 −1 −1 1 −1 1 −1 |
| | −1 −1 −1 1 −1 1 −1 −1 1 −1 1 −1 −1 −1 −1 −1 1 −1 1 1 1 1 1 −1 −1 1 1 −1 1 1 −1 |
| | 1 1 −1 −1 −1 1 1 −1 −1 1 1 −1 −1 −1 1 1 1 −1 −1 1 −1 −1 1 1 −1 −1 −1 −1 −1 1 |
| | −1 1 −1 −1 −1 −1 1 −1 1 −1 −1 1 −1 1 −1 −1 −1 −1 −1 1 −1 1 1 1 1 1 −1 −1 1 1 |
| | −1 1 1 −1 1 1 −1 −1 −1 1 1 −1 −1 1 1 −1 −1 −1 1 1 1 −1 −1 1 −1 −1 1 1 1 1 1 1 1 |
| | −1 1 −1 1 1 1 1 −1 1 −1 1 1 −1 1 −1 1 1 1 1 1 −1 1 −1 −1 −1 −1 −1 1 1 −1 −1 1 |
| | −1 −1 1 −1 −1 1 1 1 −1 −1 1 1 −1 −1 1 1 1 −1 −1 −1 1 1 −1 1 1 −1 −1 −1 −1 −1 |
| | −1 −1 1 −1 1 −1 −1 −1 −1 1 −1 1 −1 −1 1 −1 1 −1 −1 −1 −1 −1 1 −1 1 1 1 1 1 −1 |
| | −1 1 1 −1 1 1 −1 1 1 −1 −1 −1 1 1 −1 −1 1 1 −1 −1 −1 1 1 1 −1 −1 1 −1 −1 1 1 |
| | −1 −1 1 1 −1 1 1 −1 −1 −1 1 1 1 −1 −1 1 −1 1 1 −1 −1 −1 1 1 −1 1 1 −1 1 1 −1 |
| | −1 −1 −1 −1 −1 −1 1 −1 1 1 1 1 1 1 −1 1 −1 1 −1 1 −1 1 −1 −1 −1 −1 1 −1 1 −1 −1 |
| | −1 −1 −1 −1 −1 1 1 −1 1 1 −1 −1 −1 1 1 1 −1 −1 1 −1 1 1 −1 −1 −1 1 1 −1 1 1 −1 |
| | 1 1 −1 −1 −1 −1 −1 −1 −1 1 −1 1 1 1 1 1 1 −1 1 −1 1 −1 1 −1 1 −1 −1 −1 −1 1 −1 1 |
| | −1 −1 −1 −1 −1 1 1 −1 −1 1 −1 −1 1 1 1 −1 −1 −1 1 1 −1 1 −1 −1 1 1 1 −1 −1 1 |
| | −1 −1 1 −1 −1 1 1 1 1 1 1 1 −1 1 −1 −1 −1 −1 −1 1 −1 1 −1 1 −1 1 −1 1 1 1 1 −1 |
| | 1 −1 1 1 1 1 1 −1 −1 1 1 −1 1 1 −1 −1 −1 1 1 1 −1 −1 1 −1 1 1 −1 −1 −1 1 1 −1 1 |
| | 1 −1 1 1 −1 −1 −1 −1 −1 −1 −1 1 −1 1 1 1 1 1 −1 1 −1 1 −1 1 −1 1 −1 −1 −1 −1 1 |
| | −1 1 −1 −1 −1 −1 −1 −1 −1 −1 −1 −1 1 −1 1 −1 −1 −1 −1 1 −1 1 −1 −1 1 −1 1 −1 |
| | −1 −1 −1 −1 1 −1 1 1 1 1 1 −1 −1 1 1 −1 1 1 −1 1 1 −1 −1 −1 1 1 −1 −1 1 1 −1 |
| | −1 −1 1 1 1 −1 1 −1 −1 1 1 1 1 1 1 1 −1 1 −1 1 1 1 1 −1 1 −1 1 1 −1 1 −1 1 1 |
| | 1 1 1 −1 1 −1 −1 −1 −1 −1 1 1 −1 −1 1 −1 −1 1 −1 −1 1 1 1 −1 −1 1 1 −1 −1 1 1 |
| | 1 −1 −1 −1 1 1 −1 1 1 −1 −1 −1 −1 −1 −1 −1 1 −1 1 −1 −1 −1 −1 1 −1 1 −1 −1 1 |
| | −1 1 −1 −1 −1 −1 −1 1 −1 1 1 1 1 1 −1 −1 1 1 −1 1 1 −1 1 1 −1 −1 −1 1 1 −1 −1 |
| | 1 1 −1 −1 −1 1 1 1 −1 −1 1 −1 −1 1 1 −1 −1 −1 −1 −1 1 −1 1 −1 −1 −1 −1 1 −1 1 |
| | −1 −1 1 −1 1 −1 −1 −1 −1 −1 1 −1 1 1 1 1 1 −1 −1 1 1 −1 1 1 −1 1 1 −1 −1 −1 1 |
| | 1 −1 −1 1 1 −1 −1 −1 1 1 1 −1 −1 1 −1 −1 1 1 1 1 −1 −1 1 −1 −1 1 1 1 −1 −1 −1 |
| | 1 1 −1 1 −1 −1 1 1 1 −1 −1 1 −1 −1 1 −1 −1 1 1 1 1 1 1 1 −1 1 −1 −1 −1 −1 −1 1 |
| | −1 1 −1 1 −1 1 −1 1 1 1 1 −1 1 −1 1 1 1 1 1 −1 −1 1 1 −1 1 1 −1 −1 −1 1 1 1 −1 |
| | −1 1 −1 1 1 −1 −1 −1 1 1 −1 1 1 −1 1 1 −1 −1 −1 −1 −1 −1 −1 1 −1 1 1 1 1 1 −1 |
| | 1 −1 1 −1 1 −1 1 −1 −1 −1 −1 1 −1 1 −1 −1 −1 −1 −1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 −1 −1 −1 −1 −1 1 −1 1 −1 |
| | −1 −1 −1 1 −1 1 −1 −1 1 −1 1 −1 −1 −1 −1 −1 1 −1 1 1 1 1 1 −1 −1 1 1 −1 1 1 −1 |
| | 1 1 −1 −1 −1 1 1 −1 −1 1 1 −1 −1 −1 1 1 1 −1 −1 1 −1 −1 1 1 1 1 1 1 1 −1 1 −1 1 |
| | 1 1 1 −1 1 −1 1 1 −1 1 −1 1 1 1 1 1 −1 1 −1 −1 −1 −1 −1 1 1 −1 −1 1 −1 −1 1 −1 |
| | −1 1 1 1 −1 −1 1 1 −1 −1 1 1 1 −1 −1 −1 1 1 −1 1 1 −1 −1 1 1 1 1 1 −1 1 −1 1 1 1 |
| | 1 −1 1 −1 1 1 −1 1 −1 1 1 1 1 1 −1 1 −1 −1 −1 −1 −1 1 1 −1 −1 1 −1 −1 1 −1 −1 |
| | 1 1 1 −1 −1 1 1 −1 −1 1 1 1 −1 −1 −1 1 1 −1 1 1 −1 −1 1 1 1 1 1 −1 1 −1 1 1 1 1 |
| | −1 1 −1 1 1 −1 1 −1 1 1 1 1 1 −1 1 −1 −1 −1 −1 −1 1 1 −1 −1 1 −1 −1 1 −1 −1 1 |
| | 1 1 −1 −1 1 1 −1 −1 1 1 1 −1 −1 −1 1 1 −1 1 1 −1 −1 1 1 −1 −1 1 −1 −1 1 1 1 −1 |
| | −1 −1 1 1 −1 1 −1 −1 1 1 1 −1 −1 1 −1 −1 1 −1 −1 1 1 1 1 1 1 1 −1 1 −1 −1 −1 |
| | −1 −1 1 −1 1 −1 1 −1 1 −1 1 1 1 1 −1 1 −1 1 1 1 1 1 −1 −1 1 1 −1 1 1 −1 −1 −1 1 |
| | 1 1 −1 −1 1 −1 1 1 −1 −1 −1 1 1 −1 1 1 −1 1 1 −1 −1 −1 −1 −1 −1 −1 1 −1 1 1 1 |
| | 1 1 −1 1 −1 1 −1 1 −1 1 −1 −1 −1 −1 1 −1 1 −1 −1 −1 −1 −1 −1 −1 1 1 −1 1 1 −1 |
| | −1 −1 1 1 1 −1 −1 1 −1 1 1 −1 −1 −1 1 1 −1 1 1 −1 1 1 −1 −1 −1 −1 −1 −1 −1 1 |
| | −1 1 1 1 1 1 −1 1 −1 1 −1 1 −1 1 −1 −1 −1 −1 1 −1 1 −1 −1 −1 −1 −1 −1 −1 1 1 |
| | −1 1 1 −1 −1 −1 1 1 1 −1 −1 1 −1 1 1 −1 −1 −1 1 1 −1 1 1 −1 1 1 −1 −1 −1 −1 −1 |
| | −1 −1 1 −1 1 1 1 1 1 −1 1 −1 1 −1 1 −1 1 −1 −1 −1 −1 1 −1 1 −1 −1 −1 −1 −1 1 1 |
| | 1 1 1 −1 1 −1 1 1 1 1 −1 1 −1 1 1 −1 1 −1 1 1 1 1 1 −1 1 −1 −1 −1 −1 −1 1 1 −1 |
| | −1 1 −1 −1 1 −1 −1 1 1 1 −1 −1 1 1 −1 −1 1 1 1 −1 −1 −1 1 1 −1 1 1 −1 −1 1 1 1 |
| | 1 1 −1 1 −1 1 1 1 1 −1 1 −1 1 1 −1 1 −1 1 1 1 1 1 −1 1 −1 −1 −1 −1 −1 1 1 −1 −1 |
| | 1 −1 −1 1 −1 −1 1 1 1 −1 −1 1 1 −1 −1 1 1 1 −1 −1 −1 1 1 −1 1 1 −1 −1 1 1 1 1 1 |
| | −1 1 −1 1 1 1 1 −1 1 −1 1 1 −1 1 −1 1 1 1 1 1 −1 1 −1 −1 −1 −1 −1 1 1 −1 −1 1 |
| | −1 −1 1 −1 −1 1 1 1 −1 −1 1 1 −1 −1 1 1 1 −1 −1 −1 1 1 −1 1 1 −1 −1 −1 −1 −1 |
| | −1 −1 1 −1 1 −1 −1 −1 −1 1 −1 1 −1 −1 1 −1 1 −1 −1 −1 −1 −1 1 −1 1 1 1 1 1 −1 |
| | −1 1 1 −1 1 1 −1 1 1 −1 −1 −1 1 1 −1 −1 1 1 −1 −1 −1 1 1 1 −1 −1 1 −1 −1 1 1 1 |
| | 1 −1 −1 1 −1 −1 1 1 1 −1 −1 −1 1 1 −1 1 −1 −1 1 1 1 −1 −1 1 −1 −1 1 −1 −1 1 1 |
| | 1 1 1 1 1 −1 1 −1 −1 −1 −1 −1 1 −1 1 −1 1 −1 1 −1 1 1 1 1 −1 1 −1 1 1 1 1 1 1 1 |
| | −1 −1 1 −1 −1 1 1 1 −1 −1 −1 1 1 −1 1 −1 −1 1 1 1 −1 −1 1 −1 −1 1 −1 −1 1 1 1 |
| | 1 1 1 1 −1 1 −1 −1 −1 −1 −1 1 −1 1 −1 1 −1 1 −1 1 1 1 1 −1 1 −1 1 1 1 1 1 1 1 −1 |
| | −1 1 −1 −1 1 1 1 −1 −1 −1 1 1 −1 1 −1 −1 1 1 1 −1 −1 1 −1 −1 1 −1 −1 1 1 1 1 1 |
| | 1 1 −1 1 −1 −1 −1 −1 −1 1 −1 1 −1 1 −1 1 −1 1 1 1 1 −1 1 −1 1 1 1 1 1 −1 −1 1 1 |
| | −1 1 1 −1 −1 −1 1 1 1 −1 −1 1 −1 1 1 −1 −1 −1 1 1 −1 1 1 −1 1 1 −1 −1 −1 −1 −1 |
| | −1 −1 1 −1 1 1 1 1 1 −1 1 −1 1 −1 1 −1 1 −1 −1 −1 −1 1 −1 1 −1 −1 −1 −1 −1 −1 |
| | −1 −1 −1 −1 1 −1 1 −1 −1 −1 −1 1 −1 1 −1 −1 1 −1 1 −1 −1 −1 −1 −1 1 −1 1 1 1 |
| | 1 1 −1 −1 1 1 −1 1 1 −1 1 1 −1 −1 −1 1 1 −1 −1 1 1 −1 −1 −1 1 1 1 −1 −1 1 −1 |
| | −1 1 1 −1 −1 −1 −1 −1 1 −1 1 −1 −1 −1 −1 1 −1 1 −1 −1 1 −1 1 −1 −1 −1 −1 −1 |
| | 1 −1 1 1 1 1 1 −1 −1 1 1 −1 1 1 −1 1 1 −1 −1 −1 1 1 −1 −1 1 1 −1 −1 −1 1 1 1 −1 |
| | −1 1 −1 −1 1 1 1 1 1 1 1 −1 1 −1 1 1 1 1 −1 1 −1 1 1 −1 1 −1 1 1 1 1 1 −1 1 −1 |
| | −1 −1 −1 −1 1 1 −1 −1 1 −1 −1 1 −1 −1 1 1 1 −1 −1 1 1 −1 −1 1 1 1 −1 −1 −1 1 1 |
| | −1 1 1 −1 −1 −1 −1 −1 −1 −1 1 −1 1 −1 −1 −1 −1 1 −1 1 −1 −1 1 −1 1 −1 −1 −1 |
| | −1 −1 1 −1 1 1 1 1 1 −1 −1 1 1 −1 1 1 −1 1 1 −1 −1 −1 1 1 −1 −1 1 1 −1 −1 −1 1 |
| | 1 1 −1 −1 1 −1 −1 1 1 −1 −1 1 1 −1 1 1 −1 −1 −1 1 1 1 −1 −1 1 −1 1 1 −1 −1 −1 |
| | 1 1 −1 1 1 −1 1 1 −1 −1 −1 −1 −1 −1 −1 1 −1 1 1 1 1 1 −1 1 −1 1 −1 1 −1 1 −1 |
| | −1 −1 −1 1 −1 1 −1 −1 −1 −1 −1 −1 −1 1 1 −1 1 1 −1 −1 −1 1 1 1 −1 −1 1 −1 1 1 |
| | −1 −1 −1 1 1 −1 1 1 −1 1 1 −1 −1 −1 −1 −1 −1 −1 1 −1 1 1 1 1 1 −1 1 −1 1 −1 1 |
| | −1 1 −1 −1 −1 −1 1 −1 1 −1 −1 −1 −1 −1 1 1 −1 −1 1 −1 −1 1 1 1 −1 −1 −1 1 1 |
| | −1 1 −1 −1 1 1 1 −1 −1 1 −1 −1 1 −1 −1 1 1 1 1 1 1 1 −1 1 −1 −1 −1 −1 −1 1 −1 |
| | 1 −1 1 −1 1 −1 1 1 1 1 −1 1 −1 1 1 1 1 1 −1 −1 1 1 −1 1 1 −1 −1 −1 1 1 1 −1 −1 1 |
| | −1 1 1 −1 −1 −1 1 1 −1 1 1 −1 1 1 −1 −1 −1 −1 −1 −1 −1 1 −1 1 1 1 1 1 −1 1 −1 |
| | 1 −1 1 −1 1 −1 −1 −1 −1 1 −1 1 −1 −1 −1 −1 −1 1 1 1 1 1 −1 1 −1 1 1 1 1 −1 1 |
| | −1 1 1 −1 1 −1 1 1 1 1 1 −1 1 −1 −1 −1 −1 −1 1 1 −1 −1 1 −1 −1 1 −1 −1 1 1 1 |
| | −1 −1 1 1 −1 −1 1 1 1 −1 −1 −1 1 1 −1 1 1 −1 −1 −1 −1 −1 −1 −1 1 −1 1 −1 −1 |
| | −1 −1 1 −1 1 −1 −1 1 −1 1 −1 −1 −1 −1 −1 1 −1 1 1 1 1 1 −1 −1 1 1 −1 1 1 −1 1 |
| | 1 −1 −1 −1 1 1 −1 −1 1 1 −1 −1 −1 1 1 1 −1 −1 1 −1 −1 1 1 1 1 1 1 1 −1 1 −1 1 1 |
| | 1 1 −1 1 −1 1 1 −1 1 −1 1 1 1 1 1 −1 1 −1 −1 −1 −1 −1 1 1 −1 −1 1 −1 −1 1 −1 |
| | −1 1 1 1 −1 −1 1 1 −1 −1 1 1 1 −1 −1 −1 1 1 −1 1 1 −1 −1 1 1 1 1 1 −1 1 −1 1 1 1 |
| | 1 −1 1 −1 1 1 −1 1 −1 1 1 1 1 1 −1 1 −1 −1 −1 −1 −1 1 1 −1 −1 1 −1 −1 1 −1 −1 |
| | 1 1 1 −1 −1 1 1 −1 −1 1 1 1 −1 −1 −1 1 1 −1 1 1 −1 −1 −1 −1 1 1 −1 1 1 −1 −1 |
| | −1 1 1 1 −1 −1 1 −1 1 1 −1 −1 −1 1 1 −1 1 1 −1 1 1 −1 −1 −1 −1 −1 −1 −1 1 −1 1 |
| | 1 1 1 1 −1 1 −1 1 −1 1 −1 1 −1 −1 −1 −1 1 −1 1 −1 −1 −1 −1 −1 1 1 −1 −1 1 −1 |
| | −1 1 1 1 −1 −1 −1 1 1 −1 1 −1 −1 1 1 1 −1 −1 1 −1 −1 1 −1 −1 1 1 1 1 1 1 1 −1 1 |
| | −1 −1 −1 −1 −1 1 −1 1 −1 1 −1 1 −1 1 1 1 1 −1 1 −1 1 1 1 1 1 −1 −1 1 1 −1 1 1 |
| | −1 −1 −1 1 1 1 −1 −1 1 −1 1 1 −1 −1 −1 1 1 −1 1 1 −1 1 1 −1 −1 −1 −1 −1 −1 −1 |
| | 1 −1 1 1 1 1 1 −1 1 −1 1 −1 1 −1 1 −1 −1 −1 −1 1 −1 1 −1 −1 −1 −1 −1 −1 −1 1 1 |
| | −1 1 1 −1 −1 −1 1 1 1 −1 −1 1 −1 1 1 −1 −1 −1 1 1 −1 1 1 −1 1 1 −1 −1 −1 −1 −1 |
| | −1 −1 1 −1 1 1 1 1 1 −1 1 −1 1 −1 1 −1 1 −1 −1 −1 −1 1 −1 1 −1 −1 −1 −1 −1 −1 |
| | −1 −1 −1 −1 1 −1 1 −1 −1 −1 −1 1 −1 1 −1 −1 1 −1 1 −1 −1 −1 −1 −1 1 −1 1 1 1 |
| | 1 1 −1 −1 1 1 −1 1 1 −1 1 1 −1 −1 −1 1 1 −1 −1 1 1 −1 −1 −1 1 1 1 −1 −1 1 −1 |
| | −1 1 1 1 1 1 1 1 −1 1 −1 1 1 1 1 −1 1 −1 1 1 −1 1 −1 1 1 1 1 1 −1 1 −1 −1 −1 −1 |
| | −1 1 1 −1 −1 1 −1 −1 1 −1 −1 1 1 1 −1 −1 1 1 −1 −1 1 1 1 −1 −1 −1 1 1 −1 1 1 |
| | −1 −1 1 1 1 1 1 −1 1 −1 1 1 1 1 −1 1 −1 1 1 −1 1 −1 1 1 1 1 1 −1 1 −1 −1 −1 −1 |
| | −1 1 1 −1 −1 1 −1 −1 1 −1 −1 1 1 1 −1 −1 1 1 −1 −1 1 1 1 −1 −1 −1 1 1 −1 1 1 |
| | −1 −1 1 1 1 1 1 −1 1 −1 1 1 1 1 −1 1 −1 1 1 −1 1 −1 1 1 1 1 1 −1 1 −1 −1 −1 −1 |
| | −1 1 1 −1 −1 1 −1 −1 1 −1 −1 1 1 1 −1 −1 1 1 −1 −1 1 1 1 −1 −1 −1 1 1 −1 1 1 |
| | −1 −1 1 1 −1 −1 1 −1 −1 1 1 1 −1 −1 −1 1 1 −1 1 −1 −1 1 1 1 −1 −1 1 −1 −1 1 −1 |
| | −1 1 1 1 1 1 1 1 −1 1 −1 −1 −1 −1 −1 1 −1 1 −1 1 −1 1 −1 1 1 1 1 −1 1 −1 1 1 1 1 |
| | 1 −1 −1 1 1 −1 1 1 −1 −1 −1 1 1 1 −1 −1 1 −1 1 1 −1 −1 −1 1 1 −1 1 1 −1 1 1 −1 |
| | −1 −1 −1 −1 −1 −1 1 −1 1 1 1 1 1 −1 1 −1 1 −1 1 −1 1 −1 −1 −1 −1 1 −1 1 −1 −1 |
| | −1 −1 −1 −1 −1 1 1 −1 1 1 −1 −1 −1 1 1 1 −1 −1 1 −1 1 1 −1 −1 −1 1 1 −1 1 1 −1 |
| | 1 1 −1 −1 −1 −1 −1 −1 −1 1 −1 1 1 1 1 1 −1 1 −1 1 −1 1 −1 1 −1 −1 −1 −1 1 −1 1 |
| | −1 −1 −1 −1 −1 −1 −1 1 1 −1 1 1 −1 −1 −1 1 1 1 −1 −1 1 −1 1 1 −1 −1 −1 1 1 −1 |
| | 1 1 −1 1 1 −1 −1 −1 −1 −1 −1 −1 1 −1 1 1 1 1 1 −1 1 −1 1 −1 1 −1 1 −1 −1 −1 −1 |
| | 1 −1 1 −1 −1 −1 −1 −1 |
| 8 | 1 1 1 1 1 1 1 1 1 1 1 1 −1 −1 −1 −1 1 1 1 1 −1 −1 −1 −1 1 1 1 1 1 1 1 1 1 1 −1 −1 |
| | 1 1 −1 −1 1 1 −1 −1 −1 −1 1 1 1 1 −1 −1 −1 −1 1 1 1 1 −1 −1 1 1 −1 −1 1 1 1 1 1 |
| | 1 1 1 1 1 1 1 −1 −1 −1 −1 −1 −1 −1 −1 1 1 1 1 −1 −1 −1 −1 −1 −1 −1 −1 1 1 −1 |
| | −1 1 1 −1 −1 1 1 −1 −1 −1 −1 1 1 −1 −1 1 1 1 1 −1 −1 −1 −1 1 1 −1 −1 1 1 1 −1 |
| | 1 −1 1 −1 1 −1 1 −1 1 −1 −1 1 −1 1 1 −1 1 −1 −1 1 −1 1 1 −1 1 −1 1 −1 1 −1 1 |
| | −1 −1 1 1 −1 −1 1 1 −1 −1 1 −1 1 1 −1 1 −1 −1 1 −1 1 1 −1 1 −1 −1 1 1 −1 −1 1 |
| | −1 1 −1 1 −1 1 −1 1 −1 1 −1 1 1 −1 1 −1 1 −1 1 −1 −1 1 −1 1 1 −1 1 −1 1 −1 1 |
| | −1 −1 1 1 −1 −1 1 1 −1 −1 1 1 −1 1 −1 −1 1 1 −1 −1 1 −1 1 1 −1 1 −1 −1 1 1 −1 |
| | −1 1 1 −1 1 −1 1 −1 1 −1 1 −1 1 −1 −1 1 −1 1 1 −1 1 −1 −1 1 −1 1 1 −1 1 −1 1 |
| | −1 1 −1 1 −1 −1 1 1 −1 −1 1 1 −1 −1 1 −1 1 1 −1 1 −1 −1 1 −1 1 1 −1 1 −1 −1 1 |
| | 1 −1 −1 1 1 −1 1 −1 1 −1 1 −1 1 −1 1 −1 −1 1 −1 1 −1 1 −1 1 1 −1 1 −1 −1 1 −1 |
| | 1 −1 1 −1 1 1 −1 −1 1 1 −1 −1 1 1 −1 −1 1 −1 1 1 −1 −1 1 1 −1 1 −1 −1 1 −1 1 1 |
| | −1 −1 1 1 −1 1 1 1 1 1 1 1 1 1 1 1 1 −1 −1 −1 −1 1 1 1 1 −1 −1 −1 −1 1 1 1 1 1 1 |
| | 1 1 1 1 −1 −1 1 1 −1 −1 1 1 −1 −1 −1 −1 1 1 1 1 −1 −1 −1 −1 1 1 1 1 −1 −1 1 1 |
| | −1 −1 −1 −1 −1 −1 −1 −1 −1 −1 −1 −1 −1 −1 1 1 1 1 1 1 1 1 −1 −1 −1 −1 1 1 1 1 |
| | 1 1 1 1 −1 −1 1 1 −1 −1 1 1 −1 −1 1 1 1 1 −1 −1 1 1 −1 −1 −1 −1 1 1 1 1 −1 −1 1 |
| | 1 −1 −1 1 1 −1 −1 1 1 −1 −1 1 1 −1 −1 −1 −1 1 1 1 1 −1 −1 −1 −1 1 1 1 1 −1 −1 |
| | 1 1 −1 −1 1 1 1 1 1 1 1 1 1 1 1 1 −1 −1 −1 −1 1 1 1 1 −1 −1 −1 −1 1 1 1 1 1 1 1 1 |
| | 1 1 −1 −1 1 1 −1 −1 1 1 −1 −1 −1 −1 1 1 −1 −1 1 1 1 1 −1 −1 −1 −1 1 1 −1 −1 1 |
| | 1 1 1 1 1 1 1 1 1 1 1 1 1 −1 −1 −1 −1 −1 −1 −1 −1 1 1 1 1 −1 −1 −1 −1 −1 −1 −1 |
| | −1 1 −1 −1 1 1 −1 −1 1 1 −1 −1 1 −1 1 1 −1 1 −1 −1 1 −1 1 1 −1 1 −1 −1 1 1 −1 |
| | −1 1 1 −1 1 −1 1 −1 1 −1 1 −1 1 −1 −1 1 −1 1 1 −1 1 −1 −1 1 −1 1 1 −1 1 −1 1 |
| | −1 1 −1 −1 1 1 −1 −1 1 1 −1 −1 1 1 −1 1 −1 −1 1 1 −1 −1 1 −1 1 1 −1 1 −1 −1 1 |
| | 1 −1 −1 1 −1 1 −1 1 −1 1 −1 1 −1 1 −1 1 1 −1 1 −1 1 −1 1 −1 −1 1 −1 1 1 −1 1 |
| | −1 1 −1 1 −1 1 −1 −1 1 1 −1 −1 1 1 −1 −1 1 −1 1 1 −1 1 −1 −1 1 −1 1 1 −1 1 −1 |
| | −1 1 1 −1 −1 1 1 −1 1 −1 1 −1 1 −1 1 −1 1 −1 −1 1 −1 1 1 −1 1 −1 −1 1 −1 1 1 |
| | −1 1 −1 1 −1 1 −1 1 −1 −1 1 1 −1 −1 1 1 −1 −1 1 −1 1 1 −1 −1 1 1 −1 1 −1 −1 1 |
| | −1 1 1 −1 −1 1 1 −1 1 −1 1 −1 1 −1 1 −1 1 −1 1 −1 −1 1 −1 1 −1 1 −1 1 1 −1 1 |
| | −1 −1 1 −1 1 −1 1 −1 1 1 1 −1 −1 1 1 −1 −1 1 1 −1 −1 −1 −1 1 1 1 1 −1 −1 −1 −1 |
| | 1 1 1 1 −1 −1 1 1 −1 −1 1 1 1 1 1 1 1 1 1 1 1 1 −1 −1 −1 −1 1 1 1 1 −1 −1 −1 −1 |
| | 1 1 1 1 1 1 1 1 −1 −1 1 1 −1 −1 1 1 −1 −1 1 1 1 1 −1 −1 1 1 −1 −1 −1 −1 1 1 1 1 |
| | −1 −1 1 1 −1 −1 −1 −1 −1 −1 −1 −1 −1 −1 −1 −1 −1 −1 1 1 1 1 1 1 1 1 −1 −1 −1 |
| | −1 1 1 1 1 1 1 1 1 1 1 1 1 1 1 1 1 1 1 1 1 −1 −1 −1 −1 1 1 1 1 −1 −1 −1 −1 1 1 1 1 |
| | 1 1 1 1 −1 −1 1 1 −1 −1 1 1 −1 −1 1 1 1 1 −1 −1 −1 −1 1 1 1 1 −1 −1 −1 −1 1 1 |
| | −1 −1 1 1 1 1 1 1 1 1 1 1 1 1 1 1 −1 −1 −1 −1 −1 −1 −1 −1 1 1 1 1 −1 −1 −1 −1 |
| | −1 −1 −1 −1 −1 −1 1 −1 −1 1 1 −1 −1 1 1 1 1 −1 −1 1 1 −1 −1 −1 1 1 1 1 −1 |
| | −1 1 1 −1 −1 1 −1 1 −1 1 −1 1 −1 1 −1 1 −1 −1 1 −1 1 1 −1 1 −1 −1 1 −1 1 1 −1 |
| | 1 −1 1 −1 1 −1 −1 1 1 −1 −1 1 1 −1 −1 1 1 −1 1 −1 −1 1 −1 1 1 −1 1 −1 −1 1 −1 |
| | 1 1 −1 −1 1 1 −1 −1 1 −1 1 −1 1 −1 1 −1 1 −1 1 1 −1 1 −1 1 −1 1 −1 −1 1 −1 1 1 |
| | −1 1 −1 1 −1 1 −1 1 −1 −1 1 1 −1 −1 1 1 −1 −1 1 −1 1 1 −1 −1 1 1 −1 1 −1 −1 1 |
| | −1 1 1 −1 −1 1 1 −1 −1 1 −1 1 −1 1 −1 1 −1 1 −1 1 1 −1 1 −1 −1 1 −1 1 1 −1 1 |
| | −1 −1 1 −1 1 −1 1 −1 1 1 −1 −1 1 1 −1 −1 1 1 −1 −1 1 −1 1 1 −1 1 −1 −1 1 −1 1 |
| | 1 −1 1 −1 −1 1 1 −1 −1 1 −1 1 −1 1 −1 1 −1 1 −1 1 −1 1 1 −1 1 −1 1 −1 1 −1 −1 |
| | 1 −1 1 1 −1 1 −1 1 −1 1 −1 1 −1 −1 1 1 −1 −1 1 1 −1 −1 1 −1 1 1 −1 −1 1 1 −1 1 |
| | −1 −1 1 −1 1 1 −1 −1 1 1 −1 −1 −1 −1 −1 −1 −1 −1 −1 −1 −1 −1 1 1 1 1 −1 |
| | −1 −1 −1 1 1 1 1 −1 −1 −1 −1 −1 −1 −1 −1 1 1 −1 −1 1 1 −1 −1 1 1 −1 −1 −1 −1 |
| | 1 1 1 1 −1 −1 −1 −1 1 1 1 1 −1 −1 1 1 −1 −1 1 1 1 1 1 1 1 1 1 1 1 1 −1 −1 −1 −1 |
| | −1 −1 −1 −1 1 1 1 1 −1 −1 −1 −1 −1 −1 −1 −1 −1 −1 1 1 −1 −1 1 1 −1 −1 1 1 1 1 |
| | −1 −1 1 1 −1 −1 1 1 1 1 1 1 −1 −1 1 1 −1 −1 1 1 −1 −1 1 1 −1 −1 1 1 −1 −1 −1 |
| | −1 1 1 1 1 −1 −1 −1 −1 1 1 1 1 −1 −1 1 1 −1 −1 −1 −1 −1 −1 −1 −1 −1 −1 −1 −1 |
| | −1 −1 1 1 1 1 −1 −1 −1 −1 1 1 1 1 −1 −1 −1 −1 −1 −1 −1 −1 1 1 −1 −1 1 1 −1 −1 |
| | 1 1 −1 −1 −1 −1 1 1 −1 −1 1 1 1 1 −1 −1 −1 −1 1 1 −1 −1 1 1 −1 −1 −1 −1 −1 −1 |
| | −1 −1 −1 −1 −1 −1 1 1 1 1 1 1 1 1 −1 −1 −1 −1 1 1 1 1 1 1 1 1 1 −1 −1 1 1 −1 −1 |
| | 1 1 −1 −1 1 −1 1 1 −1 1 −1 1 −1 1 1 −1 1 −1 −1 1 1 −1 −1 1 −1 1 −1 1 −1 1 |
| | −1 1 −1 1 −1 1 1 −1 1 −1 −1 1 −1 1 1 −1 1 −1 −1 1 −1 1 −1 1 −1 1 −1 1 1 −1 −1 |
| | 1 1 −1 −1 1 1 −1 1 −1 −1 1 1 −1 −1 1 −1 1 1 −1 1 −1 −1 1 1 −1 −1 1 1 −1 1 −1 1 |
| | −1 1 −1 1 −1 1 −1 −1 1 −1 1 −1 1 −1 1 1 −1 1 −1 −1 1 −1 1 −1 1 −1 1 −1 1 1 −1 |
| | −1 1 1 −1 −1 1 1 −1 1 −1 −1 1 −1 1 1 −1 1 −1 −1 1 −1 1 1 −1 −1 1 1 −1 1 −1 1 |
| | −1 1 −1 1 −1 1 −1 1 −1 −1 1 −1 1 1 −1 1 −1 −1 1 −1 1 1 −1 1 −1 1 −1 1 −1 −1 1 |
| | 1 −1 −1 1 1 −1 −1 1 1 −1 1 −1 −1 1 1 −1 −1 1 −1 1 1 −1 1 −1 −1 1 1 −1 −1 1 1 |
| | −1 1 −1 1 −1 1 −1 1 −1 1 −1 −1 1 −1 1 −1 1 −1 1 1 −1 1 −1 −1 1 −1 1 −1 1 −1 1 |
| | −1 −1 1 1 −1 −1 1 1 −1 −1 1 1 1 1 −1 −1 −1 −1 1 1 1 1 −1 −1 −1 −1 1 1 −1 −1 1 |
| | 1 1 1 1 1 1 1 1 1 1 1 1 1 −1 −1 −1 −1 1 1 1 1 −1 −1 −1 −1 1 1 1 1 1 1 1 1 1 1 −1 |
| | −1 1 1 −1 −1 1 1 −1 −1 −1 −1 1 1 −1 −1 1 1 1 1 −1 −1 −1 −1 1 1 −1 −1 1 1 −1 −1 |
| | −1 −1 −1 −1 −1 −1 −1 −1 −1 −1 1 1 1 1 1 1 1 1 −1 −1 −1 −1 1 1 1 1 1 1 1 1 1 1 1 |
| | 1 1 1 1 1 1 1 1 1 −1 −1 −1 −1 1 1 1 1 −1 −1 −1 −1 1 1 1 1 1 1 1 1 1 1 −1 −1 1 1 |
| | −1 −1 1 1 −1 −1 −1 −1 1 1 1 1 −1 −1 −1 −1 1 1 1 1 −1 −1 1 1 −1 −1 1 1 1 1 1 1 1 |
| | 1 1 1 1 1 −1 −1 −1 −1 −1 −1 −1 −1 1 1 1 1 −1 −1 −1 −1 −1 −1 −1 −1 1 1 −1 −1 1 |
| | 1 −1 −1 1 1 −1 −1 −1 −1 1 1 −1 −1 1 1 1 1 −1 −1 −1 −1 1 1 −1 −1 1 1 1 −1 1 −1 |
| | 1 −1 1 −1 1 −1 1 −1 −1 1 −1 1 1 −1 1 −1 −1 1 −1 1 1 −1 1 −1 1 −1 1 −1 1 −1 −1 |
| | 1 1 −1 −1 1 1 −1 −1 1 −1 1 1 −1 1 −1 −1 1 −1 1 1 −1 1 −1 −1 1 1 −1 −1 1 −1 1 |
| | −1 1 −1 1 −1 1 −1 1 −1 1 1 −1 1 −1 1 −1 1 −1 −1 1 −1 1 1 −1 1 −1 1 −1 1 −1 −1 |
| | 1 1 −1 −1 1 1 −1 −1 1 1 −1 1 −1 −1 1 1 −1 −1 1 −1 1 1 −1 1 −1 −1 1 1 −1 −1 1 1 |
| | −1 1 −1 1 −1 1 −1 1 −1 1 −1 −1 1 −1 1 1 −1 1 −1 −1 1 −1 1 1 −1 1 −1 1 −1 1 −1 |
| | 1 −1 −1 1 1 −1 −1 1 1 −1 −1 1 −1 1 1 −1 1 −1 −1 1 −1 1 1 −1 1 −1 −1 1 1 −1 −1 |
| | 1 1 −1 1 −1 1 −1 1 −1 1 −1 1 −1 −1 1 −1 1 −1 1 −1 1 1 −1 1 −1 −1 1 −1 1 −1 1 |
| | −1 1 1 −1 −1 1 1 −1 −1 1 1 −1 −1 1 −1 1 1 −1 −1 1 1 −1 1 −1 −1 1 −1 1 1 −1 −1 |
| | 1 1 −1 1 1 1 1 1 1 1 1 1 1 1 1 −1 −1 −1 −1 1 1 1 1 −1 −1 −1 −1 1 1 1 1 1 1 1 1 1 1 |
| | −1 −1 1 1 −1 −1 1 1 −1 −1 −1 −1 1 1 1 1 −1 −1 −1 −1 1 1 1 1 −1 −1 1 1 −1 −1 −1 |
| | −1 −1 −1 −1 −1 −1 −1 −1 −1 −1 −1 1 1 1 1 1 1 1 1 −1 −1 −1 −1 1 1 1 1 1 1 1 1 |
| | −1 −1 1 1 −1 −1 1 1 −1 −1 1 1 1 1 −1 −1 1 1 −1 −1 −1 −1 1 1 1 1 −1 −1 1 1 −1 |
| | −1 −1 −1 1 1 −1 −1 1 1 −1 −1 1 1 1 1 −1 −1 −1 −1 1 1 1 1 −1 −1 −1 −1 1 1 −1 −1 |
| | 1 1 −1 −1 −1 −1 −1 −1 −1 −1 −1 −1 −1 −1 1 1 1 1 −1 −1 −1 −1 1 1 1 1 −1 −1 −1 |
| | −1 −1 −1 −1 −1 −1 −1 1 1 −1 −1 1 1 −1 −1 1 1 1 1 −1 −1 1 1 −1 −1 −1 −1 1 1 1 1 |
| | −1 −1 1 1 −1 −1 −1 −1 −1 −1 −1 −1 −1 −1 −1 −1 −1 −1 1 1 1 1 1 1 1 1 −1 −1 −1 |
| | −1 1 1 1 1 1 1 1 1 −1 1 1 −1 −1 1 1 −1 −1 1 1 −1 1 −1 −1 1 −1 1 1 −1 1 −1 −1 1 |
| | −1 1 1 −1 −1 1 1 −1 −1 1 −1 1 −1 1 −1 1 −1 1 −1 1 1 −1 1 −1 −1 1 −1 1 1 −1 1 |
| | −1 −1 1 −1 1 −1 1 −1 1 1 −1 −1 1 1 −1 −1 1 1 −1 −1 1 −1 1 1 −1 −1 1 1 −1 1 −1 |
| | −1 1 −1 1 1 −1 −1 1 1 −1 1 −1 1 −1 1 −1 1 −1 1 −1 1 −1 −1 1 −1 1 −1 1 −1 1 1 |
| | −1 1 −1 −1 1 −1 1 −1 1 −1 1 −1 1 1 −1 −1 1 1 −1 −1 1 1 −1 1 −1 −1 1 −1 1 1 −1 |
| | 1 −1 −1 1 −1 1 1 −1 −1 1 1 −1 −1 1 −1 1 −1 1 −1 1 −1 1 −1 1 1 −1 1 −1 −1 1 −1 |
| | 1 1 −1 1 −1 −1 1 −1 1 −1 1 −1 1 −1 1 1 −1 −1 1 1 −1 −1 1 1 −1 1 −1 −1 1 1 −1 |
| | −1 1 −1 1 1 −1 1 −1 −1 1 1 −1 −1 1 −1 1 −1 1 −1 1 −1 1 −1 1 −1 1 1 −1 1 −1 1 |
| | −1 1 −1 −1 1 −1 1 1 −1 1 −1 1 −1 1 −1 −1 −1 1 1 −1 −1 1 1 −1 −1 1 1 1 1 −1 −1 |
| | −1 −1 1 1 1 1 −1 −1 −1 −1 1 1 −1 −1 1 1 −1 −1 −1 −1 −1 −1 −1 −1 −1 −1 −1 −1 |
| | 1 1 1 1 −1 −1 −1 −1 1 1 1 1 −1 −1 −1 −1 −1 −1 −1 −1 1 1 −1 −1 1 1 −1 −1 1 1 −1 |
| | −1 −1 −1 1 1 −1 −1 1 1 1 1 −1 −1 −1 −1 1 1 −1 −1 1 1 1 1 1 1 1 1 1 1 1 1 1 1 −1 |
| | −1 −1 −1 −1 −1 −1 −1 1 1 1 1 −1 −1 −1 −1 −1 −1 −1 −1 1 1 1 1 1 1 1 1 1 1 1 1 |
| | −1 −1 −1 −1 1 1 1 1 −1 −1 −1 −1 1 1 1 1 1 1 1 1 −1 −1 1 1 −1 −1 1 1 −1 −1 1 1 1 |
| | 1 −1 −1 −1 −1 1 1 1 1 −1 −1 −1 −1 1 1 −1 −1 1 1 1 1 1 1 1 1 1 1 1 1 1 1 −1 −1 −1 |
| | −1 −1 −1 −1 −1 1 1 1 1 −1 −1 −1 −1 −1 −1 −1 −1 −1 −1 1 1 −1 −1 1 1 −1 −1 1 1 |
| | 1 1 −1 −1 1 1 −1 −1 −1 −1 1 1 1 1 −1 −1 1 1 −1 −1 1 −1 1 −1 1 −1 1 −1 1 −1 1 |
| | −1 −1 1 −1 1 1 −1 1 −1 −1 1 −1 1 1 −1 1 −1 1 −1 1 −1 −1 1 1 −1 −1 1 1 −1 −1 1 |
| | 1 −1 1 −1 −1 1 −1 1 1 −1 1 −1 −1 1 −1 1 1 −1 −1 1 1 −1 −1 1 −1 1 −1 1 −1 1 −1 |
| | 1 −1 1 1 −1 1 −1 1 −1 1 −1 −1 1 −1 1 1 −1 1 −1 1 −1 1 −1 1 −1 −1 1 1 −1 −1 1 1 |
| | −1 −1 1 −1 1 1 −1 −1 1 1 −1 1 −1 −1 1 −1 1 1 −1 −1 1 1 −1 −1 1 −1 1 −1 1 −1 1 |
| | −1 1 −1 1 1 −1 1 −1 −1 1 −1 1 1 −1 1 −1 −1 1 −1 1 −1 1 −1 1 1 −1 −1 1 1 −1 −1 |
| | 1 1 −1 −1 1 −1 1 1 −1 1 −1 −1 1 −1 1 1 −1 1 −1 −1 1 1 −1 −1 1 −1 1 −1 1 −1 1 |
| | −1 1 −1 1 −1 1 1 −1 1 −1 1 −1 1 −1 −1 1 −1 1 1 −1 1 −1 1 −1 1 −1 1 −1 −1 1 1 |
| | −1 −1 1 1 −1 −1 1 −1 1 1 −1 −1 1 1 −1 1 −1 −1 1 −1 1 1 −1 −1 1 1 −1 −1 −1 −1 |
| | −1 −1 −1 −1 −1 −1 −1 −1 −1 1 1 1 1 −1 −1 −1 −1 1 1 1 1 −1 −1 −1 −1 −1 −1 −1 |
| | −1 1 1 −1 −1 1 1 −1 −1 1 1 −1 −1 −1 −1 1 1 1 1 −1 −1 −1 −1 1 1 1 1 −1 −1 1 1 |
| | −1 −1 1 1 1 1 1 1 1 1 1 1 1 1 −1 −1 −1 −1 −1 −1 −1 −1 1 1 1 1 −1 −1 −1 −1 −1 |
| | −1 −1 −1 −1 −1 1 1 −1 −1 1 1 −1 −1 1 1 1 1 −1 −1 1 1 −1 −1 −1 −1 1 1 1 1 −1 −1 |
| | 1 1 −1 −1 −1 −1 1 1 −1 −1 1 1 −1 −1 1 1 1 1 −1 −1 −1 −1 1 1 1 1 −1 −1 −1 −1 1 |
| | 1 −1 −1 1 1 1 1 1 1 1 1 1 1 1 1 1 1 −1 −1 −1 −1 1 1 1 1 −1 −1 −1 −1 1 1 1 1 1 1 1 |
| | 1 −1 −1 1 1 −1 −1 1 1 −1 −1 1 1 1 1 −1 −1 1 1 −1 −1 −1 −1 1 1 1 1 −1 −1 1 1 −1 |
| | −1 1 1 1 1 1 1 1 1 1 1 1 1 −1 −1 −1 −1 −1 −1 −1 −1 1 1 1 1 −1 −1 −1 −1 −1 −1 |
| | −1 −1 −1 1 1 −1 −1 1 1 −1 −1 1 1 −1 1 −1 −1 1 −1 1 1 −1 1 −1 −1 1 −1 1 1 −1 −1 |
| | 1 1 −1 1 −1 1 −1 1 −1 1 −1 1 −1 1 −1 −1 1 −1 1 1 −1 1 −1 −1 1 −1 1 1 −1 1 −1 1 |
| | −1 1 −1 1 −1 −1 1 1 −1 −1 1 1 −1 −1 1 −1 1 1 −1 −1 1 1 −1 1 −1 −1 1 −1 1 1 −1 |
| | −1 1 1 −1 −1 1 −1 1 −1 1 −1 1 −1 1 −1 1 1 −1 1 −1 1 −1 1 −1 −1 1 −1 1 1 −1 1 |
| | −1 1 −1 1 −1 1 −1 −1 1 1 −1 −1 1 1 −1 −1 1 −1 1 1 −1 1 −1 −1 1 −1 1 1 −1 1 −1 |
| | −1 1 1 −1 −1 1 −1 1 −1 1 −1 1 −1 1 −1 1 −1 1 1 −1 1 −1 −1 1 −1 1 1 −1 1 −1 −1 |
| | 1 −1 1 −1 1 −1 1 1 −1 −1 1 1 −1 −1 1 1 −1 −1 1 −1 1 1 −1 −1 1 1 −1 1 −1 −1 1 |
| | −1 1 1 −1 −1 1 1 −1 −1 1 −1 1 −1 1 −1 1 −1 1 −1 1 1 −1 1 −1 1 −1 1 −1 −1 1 −1 |
| | 1 1 −1 1 −1 1 −1 1 −1 1 1 −1 −1 1 1 −1 −1 1 1 −1 −1 −1 −1 1 1 1 1 −1 −1 −1 −1 |
| | 1 1 1 1 −1 −1 1 1 −1 −1 −1 −1 −1 −1 −1 −1 −1 −1 −1 −1 −1 −1 1 1 1 1 −1 −1 −1 |
| | −1 1 1 1 1 −1 −1 −1 −1 −1 −1 −1 −1 −1 −1 1 1 −1 −1 1 1 −1 −1 1 1 1 1 −1 −1 1 1 |
| | −1 −1 −1 −1 1 1 1 1 −1 −1 1 1 −1 −1 1 1 1 1 1 1 1 1 1 1 1 1 −1 −1 −1 −1 −1 −1 |
| | −1 −1 1 1 1 1 −1 −1 −1 −1 −1 −1 −1 −1 −1 −1 −1 −1 −1 −1 −1 −1 −1 −1 −1 −1 1 |
| | 1 1 1 −1 −1 −1 −1 1 1 1 1 −1 −1 −1 −1 −1 −1 −1 −1 −1 −1 1 1 −1 −1 1 1 −1 −1 1 |
| | 1 1 1 −1 −1 −1 −1 1 1 1 1 −1 −1 −1 −1 1 1 −1 −1 1 1 −1 −1 −1 −1 −1 −1 −1 −1 |
| | −1 −1 −1 −1 1 1 1 1 1 1 1 1 −1 −1 −1 −1 1 1 1 1 1 1 1 1 −1 −1 1 1 −1 −1 1 1 −1 |
| | −1 1 1 1 1 −1 −1 1 1 −1 −1 −1 −1 1 1 1 1 −1 −1 1 1 −1 −1 −1 1 −1 1 −1 1 −1 1 |
| | −1 1 −1 1 1 −1 1 −1 −1 1 −1 1 1 −1 1 −1 −1 1 −1 1 −1 1 −1 1 −1 1 1 −1 −1 1 1 |
| | −1 −1 1 1 −1 1 −1 −1 1 −1 1 1 −1 1 −1 −1 1 −1 1 1 −1 −1 1 1 −1 1 −1 1 −1 1 −1 |
| | 1 −1 1 −1 1 −1 −1 1 −1 1 −1 1 −1 1 1 −1 1 −1 −1 1 −1 1 −1 1 −1 1 1 −1 −1 1 1 |
| | −1 −1 1 1 −1 −1 1 −1 1 1 −1 −1 1 1 −1 1 −1 −1 1 −1 1 1 −1 −1 1 1 −1 −1 1 −1 1 |
| | −1 1 −1 1 −1 1 −1 1 1 −1 1 −1 −1 1 −1 1 1 −1 1 −1 −1 1 −1 1 −1 1 −1 1 −1 1 1 |
| | −1 −1 1 1 −1 −1 1 1 −1 1 −1 −1 1 −1 1 1 −1 1 −1 −1 1 −1 1 1 −1 −1 1 1 −1 −1 1 |
| | −1 1 −1 1 −1 1 −1 1 −1 1 1 −1 1 −1 1 −1 1 −1 −1 1 −1 1 1 −1 1 −1 1 −1 1 −1 −1 |
| | 1 1 −1 −1 1 1 −1 −1 1 1 −1 1 −1 −1 1 1 −1 −1 1 −1 1 1 −1 1 −1 −1 1 1 −1 −1 1 |
| | −1 −1 −1 −1 −1 −1 −1 −1 −1 −1 −1 −1 1 1 1 1 −1 −1 −1 −1 1 1 1 1 −1 −1 −1 −1 |
| | −1 −1 −1 −1 −1 −1 1 1 −1 −1 1 1 −1 −1 1 1 1 1 −1 −1 −1 −1 1 1 1 1 −1 −1 −1 −1 |
| | 1 1 −1 −1 1 1 1 1 1 1 1 1 1 1 1 1 1 1 −1 −1 −1 −1 −1 −1 −1 −1 1 1 1 1 −1 −1 −1 |
| | −1 −1 −1 −1 −1 1 1 −1 −1 1 1 −1 −1 1 1 −1 −1 −1 −1 1 1 −1 −1 1 1 1 1 −1 −1 −1 |
| | −1 1 1 −1 −1 1 1 −1 −1 1 1 −1 −1 1 1 −1 −1 1 1 1 1 −1 −1 −1 −1 1 1 1 1 −1 −1 |
| | −1 −1 1 1 −1 −1 1 1 −1 −1 −1 −1 −1 −1 −1 −1 −1 −1 −1 −1 1 1 1 1 −1 −1 −1 −1 |
| | 1 1 1 1 −1 −1 −1 −1 −1 −1 −1 −1 −1 −1 1 1 −1 −1 1 1 −1 −1 1 1 1 1 −1 −1 1 1 −1 |
| | −1 −1 −1 1 1 1 1 −1 −1 1 1 −1 −1 −1 −1 −1 −1 −1 −1 −1 −1 −1 −1 −1 −1 1 1 1 1 |
| | 1 1 1 1 −1 −1 −1 −1 1 1 1 1 1 1 1 1 −1 1 1 −1 −1 1 1 −1 −1 1 1 −1 1 −1 −1 1 −1 1 |
| | 1 −1 1 −1 −1 1 −1 1 1 −1 −1 1 1 −1 −1 1 −1 1 −1 1 −1 1 −1 1 −1 1 1 −1 1 −1 −1 |
| | 1 −1 1 1 −1 1 −1 −1 1 −1 1 −1 1 −1 1 1 −1 −1 1 1 −1 −1 1 1 −1 −1 1 −1 1 1 −1 |
| | −1 1 1 −1 1 −1 −1 1 −1 1 1 −1 −1 1 1 −1 1 −1 1 −1 1 −1 1 −1 1 −1 1 −1 −1 1 −1 |
| | 1 −1 1 −1 1 1 −1 1 −1 −1 1 −1 1 −1 1 −1 1 −1 1 1 −1 −1 1 1 −1 −1 1 1 −1 1 −1 |
| | −1 1 −1 1 1 −1 1 −1 −1 1 −1 1 1 −1 −1 1 1 −1 −1 1 −1 1 −1 1 −1 1 −1 1 −1 1 1 |
| | −1 1 −1 −1 1 −1 1 1 −1 1 −1 −1 1 −1 1 −1 1 −1 1 −1 1 1 −1 −1 1 1 −1 −1 1 1 −1 |
| | 1 −1 −1 1 1 −1 −1 1 −1 1 1 −1 1 −1 −1 1 1 −1 −1 1 −1 1 −1 1 −1 1 −1 1 −1 1 −1 |
| | 1 1 −1 1 −1 1 −1 1 −1 −1 1 −1 1 1 −1 1 −1 1 −1 1 −1 −1 −1 1 1 −1 −1 1 1 −1 −1 |
| | 1 1 1 1 −1 −1 −1 −1 1 1 1 1 −1 −1 −1 −1 1 1 −1 −1 1 1 −1 −1 −1 −1 −1 −1 −1 −1 |
| | −1 −1 −1 −1 1 1 1 1 −1 −1 −1 −1 1 1 1 1 −1 −1 −1 −1 −1 −1 −1 −1 1 1 −1 −1 1 1 |
| | −1 −1 1 1 −1 −1 −1 −1 1 1 −1 −1 1 1 1 1 −1 −1 −1 −1 1 1 −1 −1 1 1 1 1 1 1 1 1 1 |
| | 1 1 1 1 1 −1 −1 −1 −1 −1 −1 −1 −1 1 1 1 1 −1 −1 −1 −1 −1 −1 −1 −1 −1 −1 −1 |
| | −1 −1 −1 −1 −1 −1 −1 −1 −1 1 1 1 1 −1 −1 −1 −1 1 1 1 1 −1 −1 −1 −1 −1 −1 −1 |
| | −1 1 1 −1 −1 1 1 −1 −1 1 1 −1 −1 −1 −1 1 1 1 1 −1 −1 −1 −1 1 1 1 1 −1 −1 1 1 |
| | −1 −1 −1 −1 −1 −1 −1 −1 −1 −1 −1 −1 −1 −1 1 1 1 1 1 1 1 1 −1 −1 −1 −1 1 1 1 1 |
| | 1 1 1 1 1 1 −1 −1 1 1 −1 −1 1 1 −1 −1 −1 −1 1 1 −1 −1 1 1 1 1 −1 −1 −1 −1 1 1 |
| | −1 −1 1 1 −1 1 −1 1 −1 1 −1 1 −1 1 −1 1 1 −1 1 −1 −1 1 −1 1 1 −1 1 −1 −1 1 −1 |
| | 1 −1 1 −1 1 1 −1 −1 1 1 −1 −1 1 1 −1 −1 1 −1 1 1 −1 1 −1 −1 1 −1 1 1 −1 1 −1 |
| | −1 1 1 −1 −1 1 1 −1 1 −1 1 −1 1 −1 1 −1 1 −1 −1 1 −1 1 −1 1 −1 1 1 −1 1 −1 −1 |
| | 1 −1 1 −1 1 −1 1 −1 1 1 −1 −1 1 1 −1 −1 1 1 −1 1 −1 −1 1 1 −1 −1 1 −1 1 1 −1 1 |
| | −1 −1 1 1 −1 −1 1 1 −1 1 −1 1 −1 1 −1 1 −1 1 −1 −1 1 −1 1 1 −1 1 −1 −1 1 −1 1 |
| | 1 −1 1 −1 1 −1 1 −1 −1 1 1 −1 −1 1 1 −1 −1 1 1 −1 1 −1 −1 1 −1 1 1 −1 1 −1 −1 |
| | 1 −1 1 1 −1 −1 1 1 −1 1 −1 1 −1 1 −1 1 −1 1 −1 1 −1 −1 1 −1 1 −1 1 −1 1 1 −1 1 |
| | −1 −1 1 −1 1 −1 1 −1 1 −1 1 1 −1 −1 1 1 −1 −1 1 1 −1 1 −1 −1 1 1 −1 −1 1 −1 1 |
| | 1 −1 1 −1 −1 1 1 −1 −1 1 1 1 1 1 1 1 1 1 1 1 1 1 −1 −1 −1 −1 1 1 1 1 −1 −1 −1 −1 |
| | 1 1 1 1 1 1 1 1 −1 −1 1 1 −1 −1 1 1 −1 −1 1 1 1 1 −1 −1 −1 −1 1 1 1 1 −1 −1 −1 |
| | −1 1 1 −1 −1 1 1 −1 −1 −1 −1 −1 −1 −1 −1 −1 −1 −1 −1 1 1 1 1 1 1 1 1 −1 −1 −1 |
| | −1 1 1 1 1 1 1 1 1 1 1 −1 −1 1 1 −1 −1 1 1 −1 −1 −1 −1 1 1 −1 −1 1 1 1 1 −1 −1 |
| | −1 −1 1 1 −1 −1 1 1 −1 −1 1 1 −1 −1 1 1 −1 −1 1 1 1 1 −1 −1 −1 −1 1 1 1 1 −1 |
| | −1 −1 −1 1 1 −1 −1 1 1 1 1 1 1 1 1 1 1 1 1 1 1 −1 −1 −1 −1 1 1 1 1 −1 −1 −1 −1 1 |
| | 1 1 1 1 1 1 1 −1 −1 1 1 −1 −1 1 1 −1 −1 1 1 1 1 −1 −1 1 1 −1 −1 −1 −1 1 1 1 1 −1 |
| | −1 1 1 −1 −1 1 1 1 1 1 1 1 1 1 1 1 1 −1 −1 −1 −1 −1 −1 −1 −1 1 1 1 1 −1 −1 −1 |
| | −1 −1 −1 −1 −1 −1 1 1 −1 −1 1 1 −1 −1 1 1 −1 1 −1 −1 1 −1 1 1 −1 1 −1 −1 1 −1 |
| | 1 1 −1 −1 1 1 −1 1 −1 1 −1 1 −1 1 −1 1 −1 1 −1 −1 1 −1 1 1 −1 1 −1 −1 1 −1 1 1 |
| | −1 1 −1 1 −1 1 −1 1 −1 −1 1 1 −1 −1 1 1 −1 −1 1 −1 1 1 −1 −1 1 1 −1 1 −1 −1 1 |
| | −1 1 1 −1 −1 1 1 −1 −1 1 −1 1 −1 1 −1 1 −1 1 −1 1 1 −1 1 −1 1 −1 1 −1 −1 1 −1 |
| | 1 1 −1 1 −1 1 −1 1 −1 1 −1 −1 1 1 −1 −1 1 1 −1 −1 1 −1 1 1 −1 1 −1 −1 1 −1 1 1 |
| | −1 1 −1 −1 1 1 −1 −1 1 −1 1 −1 1 −1 1 −1 1 −1 1 −1 1 1 −1 1 −1 −1 1 −1 1 1 −1 |
| | 1 −1 −1 1 −1 1 −1 1 −1 1 1 −1 −1 1 1 −1 −1 1 1 −1 −1 1 −1 1 1 −1 −1 1 1 −1 1 |
| | −1 −1 1 −1 1 1 −1 −1 1 1 −1 −1 1 −1 1 −1 1 −1 1 −1 1 −1 1 1 −1 1 −1 1 −1 1 −1 |
| | −1 1 −1 1 1 −1 1 −1 1 −1 1 −1 1 1 −1 −1 1 1 −1 −1 1 1 −1 −1 −1 −1 1 1 1 1 −1 |
| | −1 −1 −1 1 1 1 1 −1 −1 1 1 −1 −1 −1 −1 −1 −1 −1 −1 −1 −1 −1 −1 −1 −1 1 1 1 1 |
| | −1 −1 −1 −1 1 1 1 1 −1 −1 −1 −1 −1 −1 −1 −1 −1 −1 1 1 −1 −1 1 1 −1 −1 1 1 1 1 |
| | −1 −1 1 1 −1 −1 −1 −1 1 1 1 1 −1 −1 1 1 −1 −1 1 1 1 1 1 1 1 1 1 1 1 1 −1 −1 −1 |
| | −1 −1 −1 −1 −1 1 1 1 1 −1 −1 −1 −1 −1 −1 −1 −1 1 1 1 1 1 1 1 1 1 1 1 1 −1 −1 |
| | −1 −1 1 1 1 1 −1 −1 −1 −1 1 1 1 1 1 1 1 1 1 1 −1 −1 1 1 −1 −1 1 1 −1 −1 −1 −1 1 |
| | 1 1 1 −1 −1 −1 −1 1 1 1 1 −1 −1 1 1 −1 −1 1 1 1 1 1 1 1 1 1 1 1 1 −1 −1 −1 −1 −1 |
| | −1 −1 −1 1 1 1 1 −1 −1 −1 −1 −1 −1 −1 −1 1 1 −1 −1 1 1 −1 −1 1 1 −1 −1 −1 −1 |
| | 1 1 −1 −1 1 1 1 1 −1 −1 −1 −1 1 1 −1 −1 1 1 1 −1 1 −1 1 −1 1 −1 1 −1 1 −1 −1 1 |
| | −1 1 1 −1 1 −1 −1 1 −1 1 1 −1 1 −1 1 −1 1 −1 1 −1 −1 1 1 −1 −1 1 1 −1 −1 1 −1 |
| | 1 1 −1 1 −1 −1 1 −1 1 1 −1 1 −1 −1 1 1 −1 −1 1 −1 1 −1 1 −1 1 −1 1 −1 1 −1 1 1 |
| | −1 1 −1 1 −1 1 −1 −1 1 −1 1 1 −1 1 −1 1 −1 1 −1 −1 1 1 −1 −1 1 1 −1 −1 1 1 −1 |
| | 1 −1 −1 1 1 −1 −1 1 −1 1 1 −1 1 −1 −1 1 1 −1 −1 1 1 −1 1 −1 1 −1 1 −1 1 −1 1 |
| | −1 −1 1 −1 1 1 −1 1 −1 −1 1 −1 1 1 −1 1 −1 1 −1 1 −1 1 −1 −1 1 1 −1 −1 1 1 −1 |
| | −1 1 −1 1 1 −1 1 −1 −1 1 −1 1 1 −1 1 −1 −1 1 1 −1 −1 1 1 −1 1 −1 1 −1 1 −1 1 |
| | −1 1 −1 −1 1 −1 1 −1 1 −1 1 1 −1 1 −1 −1 1 −1 1 −1 1 −1 1 1 −1 −1 1 1 −1 −1 1 |
| | 1 −1 −1 1 −1 1 1 −1 −1 1 1 −1 1 −1 −1 1 −1 1 1 −1 −1 1 1 −1 1 1 1 1 1 1 1 1 1 1 |
| | 1 1 −1 −1 −1 −1 1 1 1 1 −1 −1 −1 −1 1 1 1 1 1 1 1 1 1 1 −1 −1 1 1 −1 −1 1 1 −1 |
| | −1 −1 −1 1 1 1 1 −1 −1 −1 −1 1 1 1 1 −1 −1 1 1 −1 −1 −1 −1 −1 −1 −1 −1 −1 −1 |
| | −1 −1 −1 −1 1 1 1 1 1 1 1 1 −1 −1 −1 −1 1 1 1 1 1 1 1 1 −1 −1 1 1 −1 −1 1 1 −1 |
| | −1 1 1 1 1 −1 −1 1 1 −1 −1 −1 −1 1 1 1 1 −1 −1 1 1 −1 −1 −1 −1 1 1 −1 −1 1 1 |
| | −1 −1 1 1 1 1 −1 −1 −1 −1 1 1 1 1 −1 −1 −1 −1 1 1 −1 −1 1 1 −1 −1 −1 −1 −1 −1 |
| | −1 −1 −1 −1 −1 −1 1 1 1 1 −1 −1 −1 −1 1 1 1 1 −1 −1 −1 −1 −1 −1 −1 −1 −1 −1 |
| | 1 1 −1 −1 1 1 −1 −1 1 1 1 1 −1 −1 1 1 −1 −1 −1 −1 1 1 1 1 −1 −1 1 1 −1 −1 −1 |
| | −1 −1 −1 −1 −1 −1 −1 −1 −1 −1 −1 1 1 1 1 1 1 1 1 −1 −1 −1 −1 1 1 1 1 1 1 1 1 |
| | −1 1 1 −1 −1 1 1 −1 −1 1 1 −1 1 −1 −1 1 −1 1 1 −1 1 −1 −1 1 −1 1 1 −1 −1 1 1 |
| | −1 −1 1 −1 1 −1 1 −1 1 −1 1 −1 1 1 −1 1 −1 −1 1 −1 1 1 −1 1 −1 −1 1 −1 1 −1 1 |
| | −1 1 1 −1 −1 1 1 −1 −1 1 1 −1 −1 1 −1 1 1 −1 −1 1 1 −1 1 −1 −1 1 −1 1 1 −1 −1 |
| | 1 1 −1 1 −1 1 −1 1 −1 1 −1 1 −1 1 −1 −1 1 −1 1 −1 1 −1 1 1 −1 1 −1 −1 1 −1 1 |
| | −1 1 −1 1 −1 1 1 −1 −1 1 1 −1 −1 1 1 −1 1 −1 −1 1 −1 1 1 −1 1 −1 −1 1 −1 1 1 |
| | −1 −1 1 1 −1 −1 1 −1 1 −1 1 −1 1 −1 1 −1 1 1 −1 1 −1 −1 1 −1 1 1 −1 1 −1 −1 1 |
| | −1 1 −1 1 −1 1 −1 1 1 −1 −1 1 1 −1 −1 1 1 −1 1 −1 −1 1 1 −1 −1 1 −1 1 1 −1 1 |
| | −1 −1 1 1 −1 −1 1 −1 1 −1 1 −1 1 −1 1 −1 1 −1 1 1 −1 1 −1 1 −1 1 −1 −1 1 −1 1 |
| | 1 −1 1 −1 1 −1 1 −1 −1 −1 1 1 −1 −1 1 1 −1 −1 1 1 1 1 −1 −1 −1 −1 1 1 1 1 −1 |
| | −1 −1 −1 1 1 −1 −1 1 1 −1 −1 −1 −1 −1 −1 −1 −1 −1 −1 −1 −1 1 1 1 1 −1 −1 −1 |
| | −1 1 1 1 1 −1 −1 −1 −1 −1 −1 −1 −1 1 1 −1 −1 1 1 −1 −1 1 1 −1 −1 −1 −1 1 1 −1 |
| | −1 1 1 1 1 −1 −1 −1 −1 1 1 −1 −1 1 1 1 1 1 1 1 1 1 1 1 1 1 1 −1 −1 −1 −1 −1 −1 |
| | −1 −1 1 1 1 1 −1 −1 −1 −1 −1 −1 −1 −1 1 1 1 1 1 1 1 1 1 1 1 1 −1 −1 −1 −1 1 1 1 |
| | 1 −1 −1 −1 −1 1 1 1 1 1 1 1 1 −1 −1 1 1 −1 −1 1 1 −1 −1 1 1 1 1 −1 −1 −1 −1 1 1 |
| | 1 1 −1 −1 −1 −1 1 1 −1 −1 1 1 1 1 1 1 1 1 1 1 1 1 1 1 −1 −1 −1 −1 −1 −1 −1 −1 1 |
| | 1 1 1 −1 −1 −1 −1 −1 −1 −1 −1 −1 −1 1 1 −1 −1 1 1 −1 −1 1 1 1 1 −1 −1 1 1 −1 |
| | −1 −1 −1 1 1 1 1 −1 −1 1 1 −1 −1 1 −1 1 −1 1 −1 1 −1 1 −1 1 −1 −1 1 −1 1 1 −1 |
| | 1 −1 −1 1 −1 1 1 −1 1 −1 1 −1 1 −1 −1 1 1 −1 −1 1 1 −1 −1 1 1 −1 1 −1 −1 1 −1 |
| | 1 1 −1 1 −1 −1 1 −1 1 1 −1 −1 1 1 −1 −1 1 −1 1 −1 1 −1 1 −1 1 −1 1 1 −1 1 −1 1 |
| | −1 1 −1 −1 1 −1 1 1 −1 1 −1 1 −1 1 −1 1 −1 −1 1 1 −1 −1 1 1 −1 −1 1 −1 1 1 −1 |
| | −1 1 1 −1 1 −1 −1 1 −1 1 1 −1 −1 1 1 −1 −1 1 −1 1 −1 1 −1 1 −1 1 −1 1 1 −1 1 |
| | −1 −1 1 −1 1 1 −1 1 −1 −1 1 −1 1 −1 1 −1 1 1 −1 −1 1 1 −1 −1 1 1 −1 −1 1 −1 1 |
| | 1 −1 1 −1 −1 1 −1 1 1 −1 1 −1 −1 1 1 −1 −1 1 −1 1 −1 1 −1 1 −1 1 −1 1 −1 1 1 |
| | −1 1 −1 1 −1 1 −1 −1 1 −1 1 1 −1 1 −1 1 −1 1 −1 1 −1 −1 1 1 −1 −1 1 1 −1 −1 1 |
| | −1 1 1 −1 −1 1 1 −1 1 −1 −1 1 −1 1 1 −1 −1 1 1 −1 −1 −1 −1 −1 −1 −1 −1 −1 −1 |
| | −1 −1 −1 1 1 1 1 −1 −1 −1 −1 1 1 1 1 −1 −1 −1 −1 −1 −1 −1 −1 1 1 −1 −1 1 1 −1 |
| | −1 1 1 −1 −1 −1 −1 1 1 1 1 −1 −1 −1 −1 1 1 1 1 −1 −1 1 1 −1 −1 1 1 1 1 1 1 1 1 1 |
| | 1 1 1 −1 −1 −1 −1 −1 −1 −1 −1 1 1 1 1 −1 −1 −1 −1 −1 −1 −1 −1 −1 −1 1 1 −1 |
| | −1 1 1 −1 −1 1 1 1 1 −1 −1 1 1 −1 −1 −1 −1 1 1 1 1 −1 −1 1 1 −1 −1 −1 −1 1 1 |
| | −1 −1 1 1 −1 −1 1 1 1 1 −1 −1 −1 −1 1 1 1 1 −1 −1 −1 −1 1 1 −1 −1 1 1 1 1 1 1 1 |
| | 1 1 1 1 1 1 1 −1 −1 −1 −1 1 1 1 1 −1 −1 −1 −1 1 1 1 1 1 1 1 1 −1 −1 1 1 −1 −1 1 |
| | 1 −1 −1 1 1 1 1 −1 −1 1 1 −1 −1 −1 −1 1 1 1 1 −1 −1 1 1 −1 −1 1 1 1 1 1 1 1 1 1 |
| | 1 1 1 −1 −1 −1 −1 −1 −1 −1 −1 1 1 1 1 −1 −1 −1 −1 −1 −1 −1 −1 −1 1 1 −1 −1 1 |
| | 1 −1 −1 1 1 −1 1 −1 −1 1 −1 1 1 −1 1 −1 −1 1 −1 1 1 −1 −1 1 1 −1 1 −1 1 −1 1 |
| | −1 1 −1 1 −1 1 −1 −1 1 −1 1 1 −1 1 −1 −1 1 −1 1 1 −1 1 −1 1 −1 1 −1 1 −1 −1 1 |
| | 1 −1 −1 1 1 −1 −1 1 −1 1 1 −1 −1 1 1 −1 1 −1 −1 1 −1 1 1 −1 −1 1 1 −1 −1 1 −1 |
| | 1 −1 1 −1 1 −1 1 −1 1 1 −1 1 −1 1 −1 1 −1 −1 1 −1 1 1 −1 1 −1 1 −1 1 −1 1 −1 |
| | −1 1 1 −1 −1 1 1 −1 −1 1 −1 1 1 −1 1 −1 −1 1 −1 1 1 −1 1 −1 −1 1 1 −1 −1 1 −1 |
| | 1 −1 1 −1 1 −1 1 −1 1 −1 1 1 −1 1 −1 −1 1 −1 1 1 −1 1 −1 −1 1 −1 1 −1 1 −1 1 1 |
| | −1 −1 1 1 −1 −1 1 1 −1 −1 1 −1 1 1 −1 −1 1 1 −1 1 −1 −1 1 −1 1 1 −1 −1 1 1 −1 |
| | −1 1 −1 1 −1 1 −1 1 −1 1 −1 1 1 −1 1 −1 1 −1 1 −1 −1 1 −1 1 1 −1 1 −1 1 −1 1 |
| | −1 1 1 −1 −1 1 1 −1 −1 1 1 −1 −1 −1 −1 1 1 1 1 −1 −1 −1 −1 1 1 1 1 −1 −1 1 1 |
| | −1 −1 −1 −1 −1 −1 −1 −1 −1 −1 −1 −1 −1 −1 1 1 1 1 −1 −1 −1 −1 1 1 1 1 −1 −1 |
| | −1 −1 −1 −1 −1 −1 −1 −1 1 1 −1 −1 1 1 −1 −1 1 1 1 1 −1 −1 1 1 −1 −1 −1 −1 1 1 |
| | 1 1 −1 −1 1 1 −1 −1 1 1 1 1 1 1 1 1 1 1 1 1 −1 −1 −1 −1 −1 −1 −1 −1 1 1 1 1 −1 |
| | −1 −1 −1 −1 −1 −1 −1 |
| 9 | 1 1 1 1 1 −1 −1 1 1 1 1 1 1 −1 −1 1 1 1 1 1 1 −1 −1 1 1 1 1 1 1 −1 −1 1 1 1 1 1 1 |
| | −1 −1 1 1 1 1 1 1 −1 −1 1 −1 −1 −1 −1 −1 1 1 −1 −1 −1 −1 −1 −1 1 1 −1 1 −1 1 |
| | −1 1 1 −1 −1 −1 1 −1 1 −1 −1 1 1 1 −1 1 −1 1 1 −1 −1 −1 1 −1 1 −1 −1 1 1 1 −1 |
| | 1 −1 1 1 −1 −1 −1 1 −1 1 −1 −1 1 1 −1 1 −1 1 −1 −1 1 1 1 −1 1 −1 1 1 −1 −1 1 1 |
| | −1 −1 1 −1 1 −1 1 1 −1 −1 1 −1 1 −1 −1 −1 1 1 −1 1 −1 1 −1 −1 1 1 −1 1 −1 1 1 |
| | 1 −1 −1 1 −1 1 −1 1 1 −1 −1 1 −1 1 −1 1 1 −1 −1 1 −1 1 −1 1 1 −1 −1 1 −1 1 −1 |
| | 1 −1 −1 1 1 1 1 1 −1 1 1 −1 −1 −1 −1 −1 −1 1 1 −1 −1 −1 −1 −1 1 −1 −1 1 1 1 1 |
| | 1 1 −1 −1 1 1 1 1 1 −1 1 1 −1 −1 −1 −1 −1 1 −1 −1 1 1 1 1 1 −1 1 1 −1 −1 −1 −1 |
| | −1 1 1 1 1 1 −1 −1 1 1 1 1 1 1 −1 −1 1 1 1 1 1 1 −1 −1 1 1 1 1 1 1 −1 −1 1 1 1 1 1 |
| | 1 −1 −1 1 1 1 1 1 1 −1 −1 1 −1 −1 −1 −1 −1 1 1 −1 −1 −1 −1 −1 −1 1 1 −1 1 −1 1 |
| | −1 1 1 −1 −1 −1 1 −1 1 −1 −1 1 1 1 −1 1 −1 1 1 −1 −1 −1 1 −1 1 −1 −1 1 1 1 −1 |
| | 1 −1 1 1 −1 −1 −1 1 −1 1 −1 −1 1 1 −1 1 −1 1 −1 −1 1 1 1 −1 1 −1 1 1 −1 −1 1 1 |
| | −1 −1 1 −1 1 −1 1 1 −1 −1 1 −1 1 −1 −1 −1 1 1 −1 1 −1 1 −1 −1 1 1 −1 1 −1 1 1 |
| | 1 −1 −1 1 −1 1 −1 1 1 −1 −1 1 −1 1 −1 1 1 −1 −1 1 −1 1 −1 1 1 −1 −1 1 −1 1 −1 |
| | 1 −1 −1 1 1 1 1 1 −1 1 1 −1 −1 −1 −1 −1 −1 1 1 −1 −1 −1 −1 −1 1 −1 −1 1 1 1 1 |
| | 1 1 −1 −1 1 1 1 1 1 −1 1 1 −1 −1 −1 −1 −1 1 −1 −1 1 1 1 1 1 −1 1 1 −1 −1 −1 −1 |
| | −1 1 1 1 1 1 −1 −1 1 −1 −1 −1 −1 −1 1 1 −1 1 1 1 1 1 −1 −1 1 −1 −1 −1 −1 −1 1 |
| | 1 −1 1 1 1 1 1 −1 −1 1 −1 −1 −1 −1 −1 1 1 −1 −1 −1 −1 −1 −1 1 1 −1 1 1 1 1 1 |
| | −1 −1 1 1 −1 1 −1 1 1 −1 −1 1 −1 1 −1 1 1 −1 −1 1 −1 1 −1 1 1 −1 −1 1 −1 1 −1 |
| | 1 1 −1 −1 1 −1 1 −1 1 1 −1 −1 1 −1 1 −1 1 1 −1 −1 −1 1 −1 1 −1 −1 1 1 −1 1 −1 |
| | 1 −1 −1 1 1 1 1 −1 −1 1 −1 1 −1 −1 −1 1 1 −1 1 −1 1 −1 −1 1 1 −1 1 −1 1 1 1 −1 |
| | −1 1 −1 1 −1 1 1 −1 −1 1 −1 1 −1 −1 −1 1 1 −1 1 −1 1 1 1 −1 −1 1 −1 1 −1 −1 −1 |
| | 1 1 −1 1 −1 1 1 −1 −1 1 1 1 1 1 1 −1 −1 1 1 1 1 1 −1 1 1 −1 −1 −1 −1 −1 −1 1 1 |
| | −1 −1 −1 −1 −1 1 −1 −1 1 1 1 1 1 1 −1 −1 1 1 1 1 1 1 −1 −1 1 1 1 1 1 1 −1 −1 1 1 |
| | 1 1 1 1 1 1 1 1 −1 −1 1 −1 −1 −1 −1 −1 1 1 −1 1 1 1 1 1 −1 −1 1 −1 −1 −1 −1 −1 |
| | 1 1 −1 1 1 1 1 1 −1 −1 1 −1 −1 −1 −1 −1 1 1 −1 −1 −1 −1 −1 −1 1 1 −1 1 1 1 1 1 |
| | −1 −1 1 1 −1 1 −1 1 1 −1 −1 1 −1 1 −1 1 1 −1 −1 1 −1 1 −1 1 1 −1 −1 1 −1 1 −1 |
| | 1 1 −1 −1 1 −1 1 −1 1 1 −1 −1 1 −1 1 −1 1 1 −1 −1 −1 1 −1 1 −1 −1 1 1 −1 1 −1 |
| | 1 −1 −1 1 1 1 1 −1 −1 1 −1 1 −1 −1 −1 1 1 −1 1 −1 1 −1 −1 1 1 −1 1 −1 1 1 1 −1 |
| | −1 1 −1 1 −1 1 1 −1 −1 1 −1 1 −1 −1 −1 1 1 −1 1 −1 1 1 1 −1 −1 1 −1 1 −1 −1 −1 |
| | 1 1 −1 1 −1 1 1 −1 −1 1 1 1 1 1 1 −1 −1 1 1 1 1 1 −1 1 1 −1 −1 −1 −1 −1 −1 1 1 |
| | −1 −1 −1 −1 −1 1 −1 −1 1 1 1 1 1 1 −1 −1 1 1 1 1 1 1 −1 −1 1 1 1 1 1 1 −1 −1 1 1 |
| | 1 1 1 1 1 1 1 1 −1 −1 1 1 1 1 1 1 −1 −1 1 1 1 1 1 1 −1 −1 1 1 1 1 1 −1 −1 1 1 1 |
| | 1 1 1 −1 −1 1 1 1 1 1 1 −1 −1 1 −1 −1 −1 −1 −1 1 1 −1 −1 −1 −1 −1 −1 1 1 −1 1 |
| | −1 1 −1 1 1 −1 −1 −1 1 −1 1 −1 −1 1 1 1 −1 1 −1 1 1 −1 −1 −1 1 −1 1 −1 −1 1 1 |
| | 1 −1 1 −1 1 1 −1 −1 −1 1 −1 1 −1 −1 1 1 −1 1 −1 1 −1 −1 1 1 1 −1 1 −1 1 1 −1 |
| | −1 1 1 −1 −1 1 −1 1 −1 1 1 −1 −1 1 −1 1 −1 −1 −1 1 1 −1 1 −1 1 −1 −1 1 1 −1 1 |
| | −1 1 1 1 −1 −1 1 −1 1 −1 1 1 −1 −1 1 −1 1 −1 1 1 −1 −1 1 −1 1 −1 1 1 −1 −1 1 |
| | −1 1 −1 1 −1 −1 1 1 1 1 1 −1 1 1 −1 −1 −1 −1 −1 −1 1 1 −1 −1 −1 −1 −1 1 −1 −1 |
| | 1 1 1 1 1 1 −1 −1 1 1 1 1 1 −1 1 1 −1 −1 −1 −1 −1 1 −1 −1 1 1 1 1 1 −1 1 1 −1 −1 |
| | −1 −1 −1 −1 −1 −1 −1 −1 1 1 −1 −1 −1 −1 −1 −1 1 1 −1 −1 −1 −1 −1 −1 1 1 −1 |
| | −1 −1 −1 −1 −1 1 1 −1 −1 −1 −1 −1 −1 1 1 −1 −1 −1 −1 −1 −1 1 1 −1 1 1 1 1 1 |
| | −1 −1 1 1 1 1 1 1 −1 −1 1 −1 1 −1 1 −1 −1 1 1 1 −1 1 −1 1 1 −1 −1 −1 1 −1 1 −1 |
| | −1 1 1 1 −1 1 −1 1 1 −1 −1 −1 1 −1 1 −1 −1 1 1 1 −1 1 −1 1 1 −1 −1 1 −1 1 −1 1 |
| | 1 −1 −1 −1 1 −1 1 −1 −1 1 1 −1 −1 1 1 −1 1 −1 1 −1 −1 1 1 −1 1 −1 1 1 1 −1 −1 |
| | 1 −1 1 −1 1 1 −1 −1 1 −1 1 −1 −1 −1 1 1 −1 1 −1 1 −1 −1 1 1 −1 1 −1 1 −1 −1 1 |
| | 1 −1 1 −1 1 −1 −1 1 1 −1 1 −1 1 −1 1 1 −1 −1 −1 −1 −1 1 −1 −1 1 1 1 1 1 1 −1 |
| | −1 1 1 1 1 1 −1 1 1 −1 −1 −1 −1 −1 −1 1 1 −1 −1 −1 −1 −1 1 −1 −1 1 1 1 1 1 −1 |
| | 1 1 −1 −1 −1 −1 −1 1 −1 −1 1 1 1 1 1 −1 −1 −1 −1 −1 1 1 −1 1 1 1 1 1 −1 −1 1 |
| | −1 −1 −1 −1 −1 1 1 −1 1 1 1 1 1 −1 −1 1 −1 −1 −1 −1 −1 1 1 −1 1 1 1 1 1 −1 −1 |
| | 1 1 1 1 1 1 −1 −1 1 −1 −1 −1 −1 −1 1 1 −1 −1 1 −1 1 −1 −1 1 1 −1 1 −1 1 −1 −1 |
| | 1 1 −1 1 −1 1 −1 −1 1 1 −1 1 −1 1 −1 −1 1 1 −1 1 −1 1 −1 −1 1 1 −1 1 −1 1 −1 |
| | −1 1 1 1 −1 1 −1 1 1 −1 −1 1 −1 1 −1 1 1 −1 −1 −1 −1 1 1 −1 1 −1 1 1 1 −1 −1 1 |
| | −1 1 −1 1 1 −1 −1 1 −1 1 −1 −1 −1 1 1 −1 1 −1 1 −1 −1 1 1 −1 1 −1 1 1 1 −1 −1 |
| | 1 −1 1 −1 −1 −1 1 1 −1 1 −1 1 1 1 −1 −1 1 −1 1 −1 −1 1 1 −1 −1 −1 −1 −1 −1 1 1 |
| | −1 −1 −1 −1 −1 1 −1 −1 1 1 1 1 1 1 −1 −1 1 1 1 1 1 −1 1 1 −1 −1 −1 −1 −1 −1 1 |
| | 1 −1 −1 −1 −1 −1 −1 1 1 −1 −1 −1 −1 −1 −1 1 1 −1 −1 −1 −1 −1 1 1 1 1 1 −1 −1 |
| | 1 −1 −1 −1 −1 −1 1 1 −1 1 1 1 1 1 −1 −1 1 −1 −1 −1 −1 −1 1 1 −1 1 1 1 1 1 −1 |
| | −1 1 −1 −1 −1 −1 −1 1 1 −1 −1 −1 −1 −1 −1 1 1 −1 1 1 1 1 1 −1 −1 1 1 −1 1 −1 1 |
| | 1 −1 −1 1 −1 1 −1 1 1 −1 −1 1 −1 1 −1 1 1 −1 −1 1 −1 1 −1 1 1 −1 −1 1 −1 1 −1 |
| | 1 1 −1 −1 1 −1 1 −1 1 1 −1 −1 −1 1 −1 1 −1 −1 1 1 −1 1 −1 1 −1 −1 1 1 1 1 −1 |
| | −1 1 −1 1 −1 −1 −1 1 1 −1 1 −1 1 −1 −1 1 1 −1 1 −1 1 1 1 −1 −1 1 −1 1 −1 1 1 |
| | −1 −1 1 −1 1 −1 −1 −1 1 1 −1 1 −1 1 1 1 −1 −1 1 −1 1 −1 −1 −1 1 1 −1 1 −1 1 1 |
| | −1 −1 1 1 1 1 1 1 −1 −1 1 1 1 1 1 −1 1 1 −1 −1 −1 −1 −1 −1 1 1 −1 −1 −1 −1 −1 |
| | 1 −1 −1 1 1 1 1 1 1 −1 −1 1 1 1 1 1 1 −1 −1 1 1 1 1 1 1 −1 −1 1 1 1 1 1 1 1 1 1 1 |
| | −1 −1 1 1 1 1 1 1 −1 −1 1 1 1 1 1 1 −1 −1 1 1 1 1 1 1 −1 −1 1 1 1 1 1 1 −1 −1 1 1 |
| | 1 1 1 1 −1 −1 1 −1 −1 −1 −1 −1 1 1 −1 −1 −1 −1 −1 −1 1 1 −1 1 −1 1 −1 1 1 −1 |
| | −1 −1 1 −1 1 −1 −1 1 1 1 −1 1 −1 1 1 −1 −1 −1 1 −1 1 −1 −1 1 1 1 −1 1 −1 1 1 |
| | −1 −1 −1 1 −1 1 −1 −1 1 1 −1 1 −1 1 −1 −1 1 1 1 −1 1 −1 1 1 −1 −1 1 1 −1 −1 1 |
| | −1 1 −1 1 1 −1 −1 1 −1 1 −1 −1 −1 1 1 −1 1 −1 1 −1 −1 1 1 −1 1 −1 1 1 1 −1 −1 |
| | 1 −1 1 −1 1 1 −1 −1 1 −1 1 −1 1 1 −1 −1 1 −1 1 −1 1 1 −1 −1 1 −1 1 −1 1 −1 −1 |
| | 1 1 1 1 1 −1 1 1 −1 −1 −1 −1 −1 −1 1 1 −1 −1 −1 −1 −1 1 −1 −1 1 1 1 1 1 1 −1 |
| | −1 1 1 1 1 1 −1 1 1 −1 −1 −1 −1 −1 1 −1 −1 1 1 1 1 1 −1 1 1 −1 −1 −1 −1 −1 −1 |
| | −1 −1 −1 −1 1 1 −1 −1 −1 −1 −1 −1 1 1 −1 −1 −1 −1 −1 −1 1 1 −1 −1 −1 −1 −1 |
| | −1 1 1 −1 −1 −1 −1 −1 −1 1 1 −1 −1 −1 −1 −1 −1 1 1 −1 1 1 1 1 1 −1 −1 1 1 1 1 |
| | 1 1 −1 −1 1 −1 1 −1 1 −1 −1 1 1 1 −1 1 −1 1 1 −1 −1 −1 1 −1 1 −1 −1 1 1 1 −1 1 |
| | −1 1 1 −1 −1 −1 1 −1 1 −1 −1 1 1 1 −1 1 −1 1 1 −1 −1 1 −1 1 −1 1 1 −1 −1 −1 1 |
| | −1 1 −1 −1 1 1 −1 −1 1 1 −1 1 −1 1 −1 −1 1 1 −1 1 −1 1 1 1 −1 −1 1 −1 1 −1 1 1 |
| | −1 −1 1 −1 1 −1 −1 −1 1 1 −1 1 −1 1 −1 −1 1 1 −1 1 −1 1 −1 −1 1 1 −1 1 −1 1 −1 |
| | −1 1 1 −1 1 −1 1 −1 1 1 −1 −1 −1 −1 −1 1 −1 −1 1 1 1 1 1 1 −1 −1 1 1 1 1 1 −1 1 |
| | 1 −1 −1 −1 −1 −1 −1 1 1 −1 −1 −1 −1 −1 1 −1 −1 1 1 1 1 1 −1 1 1 −1 −1 −1 −1 |
| | −1 1 −1 −1 1 1 1 1 1 1 1 1 1 1 −1 −1 1 −1 −1 −1 −1 −1 1 1 −1 1 1 1 1 1 −1 −1 1 |
| | −1 −1 −1 −1 −1 1 1 −1 1 1 1 1 1 −1 −1 1 −1 −1 −1 −1 −1 1 1 −1 −1 −1 −1 −1 −1 |
| | 1 1 −1 1 1 1 1 1 −1 −1 1 1 −1 1 −1 1 1 −1 −1 1 −1 1 −1 1 1 −1 −1 1 −1 1 −1 1 1 |
| | −1 −1 1 −1 1 −1 1 1 −1 −1 1 −1 1 −1 1 1 −1 −1 1 −1 1 −1 1 1 −1 −1 −1 1 −1 1 −1 |
| | −1 1 1 −1 1 −1 1 −1 −1 1 1 1 1 −1 −1 1 −1 1 −1 −1 −1 1 1 −1 1 −1 1 −1 −1 1 1 |
| | −1 1 −1 1 1 1 −1 −1 1 −1 1 −1 1 1 −1 −1 1 −1 1 −1 −1 −1 1 1 −1 1 −1 1 1 1 −1 |
| | −1 1 −1 1 −1 −1 −1 1 1 −1 1 −1 1 1 −1 −1 1 1 1 1 1 1 −1 −1 1 1 1 1 1 −1 1 1 −1 |
| | −1 −1 −1 −1 −1 1 1 −1 −1 −1 −1 −1 1 −1 −1 1 1 1 1 1 1 −1 −1 1 1 1 1 1 1 −1 −1 |
| | 1 1 1 1 1 1 −1 −1 1 1 1 1 1 −1 −1 −1 −1 −1 1 1 −1 1 1 1 1 1 −1 −1 1 −1 −1 −1 −1 |
| | −1 1 1 −1 1 1 1 1 1 −1 −1 1 −1 −1 −1 −1 −1 1 1 −1 1 1 1 1 1 −1 −1 1 1 1 1 1 1 −1 |
| | −1 1 −1 −1 −1 −1 −1 1 1 −1 −1 1 −1 1 −1 −1 1 1 −1 1 −1 1 −1 −1 1 1 −1 1 −1 1 |
| | −1 −1 1 1 −1 1 −1 1 −1 −1 1 1 −1 1 −1 1 −1 −1 1 1 −1 1 −1 1 −1 −1 1 1 1 −1 1 |
| | −1 1 1 −1 −1 1 −1 1 −1 1 1 −1 −1 −1 −1 1 1 −1 1 −1 1 1 1 −1 −1 1 −1 1 −1 1 1 |
| | −1 −1 1 −1 1 −1 −1 −1 1 1 −1 1 −1 1 −1 −1 1 1 −1 1 −1 1 1 1 −1 −1 1 −1 1 −1 −1 |
| | −1 1 1 −1 1 −1 1 1 1 −1 −1 1 −1 1 −1 −1 1 1 −1 −1 −1 −1 −1 −1 1 1 −1 −1 −1 −1 |
| | −1 1 −1 −1 1 1 1 1 1 1 −1 −1 1 1 1 1 1 −1 1 1 −1 −1 −1 −1 −1 −1 1 1 −1 −1 −1 |
| | −1 −1 −1 1 1 −1 −1 −1 −1 −1 −1 1 1 −1 −1 −1 −1 −1 1 1 1 1 1 −1 −1 1 1 1 1 1 1 |
| | −1 −1 1 1 1 1 1 1 −1 −1 1 1 1 1 1 1 −1 −1 1 1 1 1 1 1 −1 −1 1 1 1 1 1 1 −1 −1 1 |
| | −1 −1 −1 −1 −1 1 1 −1 −1 −1 −1 −1 −1 1 1 −1 1 −1 1 −1 1 1 −1 −1 −1 1 −1 1 −1 |
| | −1 1 1 1 −1 1 −1 1 1 −1 −1 −1 1 −1 1 −1 −1 1 1 1 −1 1 −1 1 1 −1 −1 −1 1 −1 1 |
| | −1 −1 1 1 −1 1 −1 1 −1 −1 1 1 1 −1 1 −1 1 1 −1 −1 1 1 −1 −1 1 −1 1 −1 1 1 −1 |
| | −1 1 −1 1 −1 −1 −1 1 1 −1 1 −1 1 −1 −1 1 1 −1 1 −1 1 1 1 −1 −1 1 −1 1 −1 1 1 |
| | −1 −1 1 −1 1 −1 1 1 −1 −1 1 −1 1 −1 1 1 −1 −1 1 −1 1 −1 1 −1 −1 1 1 1 1 1 −1 1 |
| | 1 −1 −1 −1 −1 −1 −1 1 1 −1 −1 −1 −1 −1 1 −1 −1 1 1 1 1 1 1 −1 −1 1 1 1 1 1 −1 |
| | 1 1 −1 −1 −1 −1 −1 1 −1 −1 1 1 1 1 1 −1 1 1 −1 −1 −1 −1 −1 1 1 1 1 1 −1 −1 1 1 |
| | 1 1 1 1 −1 −1 1 1 1 1 1 1 −1 −1 1 1 1 1 1 1 −1 −1 1 1 1 1 1 1 −1 −1 1 1 1 1 1 1 −1 |
| | −1 1 −1 −1 −1 −1 −1 1 1 −1 −1 −1 −1 −1 −1 1 1 −1 1 −1 1 −1 1 1 −1 −1 −1 1 −1 |
| | 1 −1 −1 1 1 1 −1 1 −1 1 1 −1 −1 −1 1 −1 1 −1 −1 1 1 1 −1 1 −1 1 1 −1 −1 −1 1 |
| | −1 1 −1 −1 1 1 −1 1 −1 1 −1 −1 1 1 1 −1 1 −1 1 1 −1 −1 1 1 −1 −1 1 −1 1 −1 1 1 |
| | −1 −1 1 −1 1 −1 −1 −1 1 1 −1 1 −1 1 −1 −1 1 1 −1 1 −1 1 1 1 −1 −1 1 −1 1 −1 1 |
| | 1 −1 −1 1 −1 1 −1 1 1 −1 −1 1 −1 1 −1 1 1 −1 −1 1 −1 1 −1 1 −1 −1 1 1 1 1 1 −1 |
| | 1 1 −1 −1 −1 −1 −1 −1 1 1 −1 −1 −1 −1 −1 1 −1 −1 1 1 1 1 1 1 −1 −1 1 1 1 1 1 |
| | −1 1 1 −1 −1 −1 −1 −1 1 −1 −1 1 1 1 1 1 −1 1 1 −1 −1 −1 −1 −1 −1 −1 −1 −1 −1 |
| | 1 1 −1 1 1 1 1 1 −1 −1 1 −1 −1 −1 −1 −1 1 1 −1 1 1 1 1 1 −1 −1 1 −1 −1 −1 −1 |
| | −1 1 1 −1 1 1 1 1 1 −1 −1 1 1 1 1 1 1 −1 −1 1 −1 −1 −1 −1 −1 1 1 −1 −1 1 −1 1 |
| | −1 −1 1 1 −1 1 −1 1 −1 −1 1 1 −1 1 −1 1 −1 −1 1 1 −1 1 −1 1 −1 −1 1 1 −1 1 −1 |
| | 1 −1 −1 1 1 −1 1 −1 1 −1 −1 1 1 1 −1 1 −1 1 1 −1 −1 1 −1 1 −1 1 1 −1 −1 −1 −1 |
| | 1 1 −1 1 −1 1 1 1 −1 −1 1 −1 1 −1 1 1 −1 −1 1 −1 1 −1 −1 −1 1 1 −1 1 −1 1 −1 |
| | −1 1 1 −1 1 −1 1 1 1 −1 −1 1 −1 1 −1 −1 −1 1 1 −1 1 −1 1 1 1 −1 −1 1 −1 1 −1 |
| | −1 1 1 −1 −1 −1 −1 −1 −1 1 1 −1 −1 −1 −1 −1 1 −1 −1 1 1 1 1 1 1 −1 −1 1 1 1 1 |
| | 1 −1 1 1 −1 −1 −1 −1 −1 −1 1 1 −1 −1 −1 −1 −1 −1 1 1 −1 −1 −1 −1 −1 −1 1 1 |
| | −1 −1 −1 −1 −1 −1 −1 −1 −1 −1 1 1 −1 1 1 1 1 1 −1 −1 1 −1 −1 −1 −1 −1 1 1 −1 |
| | 1 1 1 1 1 −1 −1 1 −1 −1 −1 −1 −1 1 1 −1 1 1 1 1 1 −1 −1 1 1 1 1 1 1 −1 −1 1 −1 |
| | −1 −1 −1 −1 1 1 −1 −1 1 −1 1 −1 −1 1 1 −1 1 −1 1 −1 −1 1 1 −1 1 −1 1 −1 −1 1 1 |
| | −1 1 −1 1 −1 −1 1 1 −1 1 −1 1 −1 −1 1 1 −1 1 −1 1 −1 −1 1 1 1 −1 1 −1 1 1 −1 |
| | −1 1 −1 1 −1 1 1 −1 −1 −1 −1 1 1 −1 1 −1 1 1 1 −1 −1 1 −1 1 −1 1 1 −1 −1 1 −1 |
| | 1 −1 −1 −1 1 1 −1 1 −1 1 −1 −1 1 1 −1 1 −1 1 1 1 −1 −1 1 −1 1 −1 −1 −1 1 1 −1 |
| | 1 −1 1 1 1 −1 −1 1 −1 1 −1 −1 1 1 −1 −1 −1 −1 −1 −1 1 1 −1 −1 −1 −1 −1 1 −1 |
| | −1 1 1 1 1 1 1 −1 −1 1 1 1 1 1 −1 1 1 −1 −1 −1 −1 −1 −1 1 1 −1 −1 −1 −1 −1 −1 |
| | 1 1 −1 −1 −1 −1 −1 −1 1 1 −1 −1 −1 −1 −1 −1 −1 −1 −1 −1 1 1 −1 −1 −1 −1 −1 |
| | −1 1 1 −1 −1 −1 −1 −1 −1 1 1 −1 −1 −1 −1 −1 −1 1 1 −1 −1 −1 −1 −1 −1 1 1 −1 |
| | −1 −1 −1 −1 −1 1 1 −1 1 1 1 1 1 −1 −1 1 1 1 1 1 1 −1 −1 1 −1 1 −1 1 −1 −1 1 1 1 |
| | −1 1 −1 1 1 −1 −1 −1 1 −1 1 −1 −1 1 1 1 −1 1 −1 1 1 −1 −1 −1 1 −1 1 −1 −1 1 1 |
| | 1 −1 1 −1 1 1 −1 −1 1 −1 1 −1 1 1 −1 −1 −1 1 −1 1 −1 −1 1 1 −1 −1 1 1 −1 1 −1 |
| | 1 −1 −1 1 1 −1 1 −1 1 1 1 −1 −1 1 −1 1 −1 1 1 −1 −1 1 −1 1 −1 −1 −1 1 1 −1 1 |
| | −1 1 −1 −1 1 1 −1 1 −1 1 −1 −1 1 1 −1 1 −1 1 −1 −1 1 1 −1 1 −1 1 −1 1 1 −1 −1 |
| | −1 −1 −1 1 −1 −1 1 1 1 1 1 1 −1 −1 1 1 1 1 1 −1 1 1 −1 −1 −1 −1 −1 1 1 −1 |
| | −1 −1 −1 −1 1 −1 1 1 1 1 1 −1 1 1 −1 −1 −1 −1 −1 1 −1 −1 1 1 1 1 1 −1 −1 −1 |
| | −1 −1 1 1 −1 −1 −1 −1 −1 −1 1 1 −1 −1 −1 −1 −1 −1 1 1 −1 −1 −1 −1 −1 −1 1 1 |
| | −1 −1 −1 −1 −1 −1 1 1 −1 −1 −1 −1 −1 −1 1 1 −1 1 1 1 1 1 −1 −1 1 1 1 1 1 1 −1 |
| | −1 1 −1 1 −1 1 −1 −1 1 1 1 −1 1 −1 1 1 −1 −1 −1 1 −1 1 −1 −1 1 1 1 −1 1 −1 1 1 |
| | −1 −1 −1 1 −1 1 −1 −1 1 1 1 −1 1 −1 1 1 −1 −1 1 −1 1 −1 1 1 −1 −1 −1 1 −1 1 −1 |
| | −1 1 1 −1 −1 1 1 −1 1 −1 1 −1 −1 1 1 −1 1 −1 1 1 1 −1 −1 1 −1 1 −1 1 1 −1 −1 1 |
| | −1 1 −1 −1 −1 1 1 −1 1 −1 1 −1 −1 1 1 −1 1 −1 1 −1 −1 1 1 −1 1 −1 1 −1 −1 1 1 |
| | −1 1 −1 1 −1 1 1 −1 −1 −1 −1 −1 1 −1 −1 1 1 1 1 1 1 −1 −1 1 1 1 1 1 −1 1 1 −1 |
| | −1 −1 −1 −1 −1 1 1 −1 −1 −1 −1 −1 1 −1 −1 1 1 1 1 1 −1 1 1 −1 −1 −1 −1 −1 1 |
| | −1 −1 1 1 1 1 1 −1 −1 −1 −1 −1 1 1 −1 1 1 1 1 1 −1 −1 1 −1 −1 −1 −1 −1 1 1 −1 |
| | 1 1 1 1 1 −1 −1 1 −1 −1 −1 −1 −1 1 1 −1 1 1 1 1 1 −1 −1 1 1 1 1 1 1 −1 −1 1 −1 |
| | −1 −1 −1 −1 1 1 −1 −1 1 −1 1 −1 −1 1 1 −1 1 −1 1 −1 −1 1 1 −1 1 −1 1 −1 −1 1 1 |
| | −1 1 −1 1 −1 −1 1 1 −1 1 −1 1 −1 −1 1 1 −1 1 −1 1 −1 −1 1 1 1 −1 1 −1 1 1 −1 |
| | −1 1 −1 1 −1 1 1 −1 −1 −1 −1 1 1 −1 1 −1 1 1 1 −1 −1 1 −1 1 −1 1 1 −1 −1 1 −1 |
| | 1 −1 −1 −1 1 1 −1 1 −1 1 −1 −1 1 1 −1 1 −1 1 1 1 −1 −1 1 −1 1 −1 −1 −1 1 1 −1 |
| | 1 −1 1 1 1 −1 −1 1 −1 1 −1 −1 1 1 −1 −1 −1 −1 −1 −1 1 1 −1 −1 −1 −1 −1 1 −1 |
| | −1 1 1 1 1 1 1 −1 −1 1 1 1 1 1 −1 1 1 −1 −1 −1 −1 −1 −1 1 1 −1 −1 −1 −1 −1 −1 |
| | 1 1 −1 −1 −1 −1 −1 −1 1 1 −1 −1 −1 −1 −1 −1 −1 −1 −1 −1 1 1 −1 1 1 1 1 1 −1 |
| | −1 1 −1 −1 −1 −1 −1 1 1 −1 1 1 1 1 1 −1 −1 1 −1 −1 −1 −1 −1 1 1 −1 1 1 1 1 1 |
| | −1 −1 1 1 1 1 1 1 −1 −1 1 −1 −1 −1 −1 −1 1 1 −1 −1 1 −1 1 −1 −1 1 1 −1 1 −1 1 |
| | −1 −1 1 1 −1 1 −1 1 −1 −1 1 1 −1 1 −1 1 −1 −1 1 1 −1 1 −1 1 −1 −1 1 1 −1 1 −1 |
| | 1 −1 −1 1 1 1 −1 1 −1 1 1 −1 −1 1 −1 1 −1 1 1 −1 −1 −1 −1 1 1 −1 1 −1 1 1 1 −1 |
| | −1 1 −1 1 −1 1 1 −1 −1 1 −1 1 −1 −1 −1 1 1 −1 1 −1 1 −1 −1 1 1 −1 1 −1 1 1 1 |
| | −1 −1 1 −1 1 −1 −1 −1 1 1 −1 1 −1 1 1 1 −1 −1 1 −1 1 −1 −1 1 1 −1 −1 −1 −1 −1 |
| | −1 1 1 −1 −1 −1 −1 −1 1 −1 −1 1 1 1 1 1 1 −1 −1 1 1 1 1 1 −1 1 1 −1 −1 −1 −1 |
| | −1 −1 1 1 −1 −1 −1 −1 −1 −1 1 1 −1 −1 −1 −1 −1 −1 1 1 −1 −1 −1 −1 −1 −1 −1 |
| | −1 −1 −1 1 1 −1 −1 −1 −1 −1 −1 1 1 −1 −1 −1 −1 −1 −1 1 1 −1 −1 −1 −1 −1 −1 1 |
| | 1 −1 −1 −1 −1 −1 −1 1 1 −1 −1 −1 −1 −1 −1 1 1 −1 1 1 1 1 1 −1 −1 1 1 1 1 1 1 |
| | −1 −1 1 −1 1 −1 1 −1 −1 1 1 1 −1 1 −1 1 1 −1 −1 −1 1 −1 1 −1 −1 1 1 1 −1 1 −1 |
| | 1 1 −1 −1 −1 1 −1 1 −1 −1 1 1 1 −1 1 −1 1 1 −1 −1 1 −1 1 −1 1 1 −1 −1 −1 1 −1 |
| | 1 −1 −1 1 1 −1 −1 1 1 −1 1 −1 1 −1 −1 1 1 −1 1 −1 1 1 1 −1 −1 1 −1 1 −1 1 1 −1 |
| | −1 1 −1 1 −1 −1 −1 1 1 −1 1 −1 1 −1 −1 1 1 −1 1 −1 1 −1 −1 1 1 −1 1 −1 1 −1 −1 |
| | 1 1 −1 1 −1 1 −1 1 1 −1 −1 −1 −1 −1 1 −1 −1 1 1 1 1 1 1 −1 −1 1 1 1 1 1 −1 1 1 |
| | −1 −1 −1 −1 −1 −1 1 1 −1 −1 −1 −1 −1 1 −1 −1 1 1 1 1 1 −1 1 1 −1 −1 −1 −1 −1 |
| | 1 −1 −1 1 1 1 1 1 1 1 1 1 1 −1 −1 1 1 1 1 1 1 −1 −1 1 1 1 1 1 1 −1 −1 1 1 1 1 1 1 |
| | −1 −1 1 1 1 1 1 1 −1 −1 1 1 1 1 1 1 −1 −1 1 −1 −1 −1 −1 −1 1 1 −1 −1 −1 −1 −1 |
| | −1 1 1 −1 1 −1 1 −1 1 1 −1 −1 −1 1 −1 1 −1 −1 1 1 1 −1 1 −1 1 1 −1 −1 −1 1 −1 |
| | 1 −1 −1 1 1 1 −1 1 −1 1 1 −1 −1 −1 1 −1 1 −1 −1 1 1 −1 1 −1 1 −1 −1 1 1 1 −1 1 |
| | −1 1 1 −1 −1 1 1 −1 −1 1 −1 1 −1 1 1 −1 −1 1 −1 1 −1 −1 −1 1 1 −1 1 −1 1 −1 −1 |
| | 1 1 −1 1 −1 1 1 1 −1 −1 1 −1 1 −1 1 1 −1 −1 1 −1 1 −1 1 1 −1 −1 1 −1 1 −1 1 1 |
| | −1 −1 1 −1 1 −1 1 −1 −1 1 1 1 1 1 −1 1 1 −1 −1 −1 −1 −1 −1 1 1 −1 −1 −1 −1 −1 |
| | 1 −1 −1 1 1 1 1 1 1 −1 −1 1 1 1 1 1 −1 1 1 −1 −1 −1 −1 −1 1 −1 −1 1 1 1 1 1 −1 1 |
| | 1 −1 −1 −1 −1 −1 1 1 1 1 1 −1 −1 1 −1 −1 −1 −1 −1 1 1 −1 1 1 1 1 1 −1 −1 1 −1 |
| | −1 −1 −1 −1 1 1 −1 1 1 1 1 1 −1 −1 1 −1 −1 −1 −1 −1 1 1 −1 −1 −1 −1 −1 −1 1 1 |
| | −1 1 1 1 1 1 −1 −1 1 1 −1 1 −1 1 1 −1 −1 1 −1 1 −1 1 1 −1 −1 1 −1 1 −1 1 1 −1 |
| | −1 1 −1 1 −1 1 1 −1 −1 1 −1 1 −1 1 1 −1 −1 1 −1 1 −1 1 1 −1 −1 −1 1 −1 1 −1 −1 |
| | 1 1 −1 1 −1 1 −1 −1 1 1 1 1 −1 −1 1 −1 1 −1 −1 −1 1 1 −1 1 −1 1 −1 −1 1 1 −1 1 |
| | −1 1 1 1 −1 −1 1 −1 1 −1 1 1 −1 −1 1 −1 1 −1 −1 −1 1 1 −1 1 −1 1 1 1 −1 −1 1 |
| | −1 1 −1 −1 −1 1 1 −1 1 −1 1 1 −1 −1 1 1 1 1 1 1 −1 −1 1 1 1 1 1 −1 1 1 −1 −1 −1 |
| | −1 −1 −1 1 1 −1 −1 −1 −1 −1 1 −1 −1 1 1 1 1 1 1 −1 −1 1 1 1 1 1 1 −1 −1 1 1 1 1 |
| | 1 1 −1 −1 1 1 1 1 1 −1 −1 −1 −1 −1 1 1 −1 1 1 1 1 1 −1 −1 1 −1 −1 −1 −1 −1 1 1 |
| | −1 1 1 1 1 1 −1 −1 1 −1 −1 −1 −1 −1 1 1 −1 1 1 1 1 1 −1 −1 1 1 1 1 1 1 −1 −1 1 |
| | −1 −1 −1 −1 −1 1 1 −1 −1 1 −1 1 −1 −1 1 1 −1 1 −1 1 −1 −1 1 1 −1 1 −1 1 −1 −1 |
| | 1 1 −1 1 −1 1 −1 −1 1 1 −1 1 −1 1 −1 −1 1 1 −1 1 −1 1 −1 −1 1 1 1 −1 1 −1 1 1 |
| | −1 −1 1 −1 1 −1 1 1 −1 −1 −1 −1 1 1 −1 1 −1 1 1 1 −1 −1 1 −1 1 −1 1 1 −1 −1 1 |
| | −1 1 −1 −1 −1 1 1 −1 1 −1 1 −1 −1 1 1 −1 1 −1 1 1 1 −1 −1 1 −1 1 −1 −1 −1 1 1 |
| | −1 1 −1 1 1 1 −1 −1 1 −1 1 −1 −1 1 1 −1 −1 −1 −1 −1 −1 1 1 −1 −1 −1 −1 −1 1 |
| | −1 −1 1 1 1 1 1 1 −1 −1 1 1 1 1 1 −1 1 1 −1 −1 −1 −1 −1 −1 1 1 −1 −1 −1 −1 −1 |
| | −1 1 1 −1 −1 −1 −1 −1 −1 1 1 −1 −1 −1 −1 −1 1 1 1 1 1 −1 −1 1 1 1 1 1 1 −1 −1 |
| | 1 1 1 1 1 1 −1 −1 1 1 1 1 1 1 −1 −1 1 1 1 1 1 1 −1 −1 1 1 1 1 1 1 −1 −1 1 −1 −1 |
| | −1 −1 −1 1 1 −1 −1 −1 −1 −1 −1 1 1 −1 1 −1 1 −1 1 1 −1 −1 −1 1 −1 1 −1 −1 1 1 |
| | 1 −1 1 −1 1 1 −1 −1 −1 1 −1 1 −1 −1 1 1 1 −1 1 −1 1 1 −1 −1 −1 1 −1 1 −1 −1 1 |
| | 1 −1 1 −1 1 −1 −1 1 1 1 −1 1 −1 1 1 −1 −1 1 1 −1 −1 1 −1 1 −1 1 1 −1 −1 1 −1 1 |
| | −1 −1 −1 1 1 −1 1 −1 1 −1 −1 1 1 −1 1 −1 1 1 1 −1 −1 1 −1 1 −1 1 1 −1 −1 1 −1 |
| | 1 −1 1 1 −1 −1 1 −1 1 −1 1 1 −1 −1 1 −1 1 −1 1 −1 −1 1 1 1 1 1 −1 1 1 −1 −1 −1 |
| | −1 −1 −1 1 1 −1 −1 −1 −1 −1 1 −1 −1 1 1 1 1 1 1 −1 −1 1 1 1 1 1 −1 1 1 −1 −1 |
| | −1 −1 −1 1 −1 −1 1 1 1 1 1 −1 1 1 −1 −1 −1 −1 −1 −1 −1 −1 −1 −1 1 1 −1 −1 −1 |
| | −1 −1 −1 1 1 −1 −1 −1 −1 −1 −1 1 1 −1 −1 −1 −1 −1 −1 1 1 −1 −1 −1 −1 −1 −1 1 |
| | 1 −1 −1 −1 −1 −1 −1 1 1 −1 1 1 1 1 1 −1 −1 1 1 1 1 1 1 −1 −1 1 −1 1 −1 1 −1 −1 |
| | 1 1 1 −1 1 −1 1 1 −1 −1 −1 1 −1 1 −1 −1 1 1 1 −1 1 −1 1 1 −1 −1 −1 1 −1 1 −1 |
| | −1 1 1 1 −1 1 −1 1 1 −1 −1 1 −1 1 −1 1 1 −1 −1 −1 1 −1 1 −1 −1 1 1 −1 −1 1 1 |
| | −1 1 −1 1 −1 −1 1 1 −1 1 −1 1 1 1 −1 −1 1 −1 1 −1 1 1 −1 −1 1 −1 1 −1 −1 −1 1 |
| | 1 −1 1 −1 1 −1 −1 1 1 −1 1 −1 1 −1 −1 1 1 −1 1 −1 1 −1 −1 1 1 −1 1 −1 1 −1 1 1 |
| | −1 −1 −1 −1 −1 1 −1 −1 1 1 1 1 1 1 −1 −1 1 1 1 1 1 −1 1 1 −1 −1 −1 −1 −1 −1 1 |
| | 1 −1 −1 −1 −1 −1 1 −1 −1 1 1 1 1 1 −1 1 1 −1 −1 −1 −1 −1 1 −1 −1 1 1 1 1 1 1 1 |
| | 1 1 1 −1 −1 1 −1 −1 −1 −1 −1 1 1 −1 1 1 1 1 1 −1 −1 1 −1 −1 −1 −1 −1 1 1 −1 1 |
| | 1 1 1 1 −1 −1 1 −1 −1 −1 −1 −1 1 1 −1 −1 −1 −1 −1 −1 1 1 −1 1 1 1 1 1 −1 −1 1 |
| | 1 −1 1 −1 1 1 −1 −1 1 −1 1 −1 1 1 −1 −1 1 −1 1 −1 1 1 −1 −1 1 −1 1 −1 1 1 −1 |
| | −1 1 −1 1 −1 1 1 −1 −1 1 −1 1 −1 1 1 −1 −1 −1 1 −1 1 −1 −1 1 1 −1 1 −1 1 −1 −1 |
| | 1 1 1 1 −1 −1 1 −1 1 −1 −1 −1 1 1 −1 1 −1 1 −1 −1 1 1 −1 1 −1 1 1 1 −1 −1 1 −1 |
| | 1 −1 1 1 −1 −1 1 −1 1 −1 −1 −1 1 1 −1 1 −1 1 1 1 −1 −1 1 −1 1 −1 −1 −1 1 1 −1 |
| | 1 −1 1 1 −1 −1 1 1 1 1 1 1 −1 −1 1 1 1 1 1 −1 1 1 −1 −1 −1 −1 −1 −1 1 1 −1 −1 |
| | −1 −1 −1 1 −1 −1 1 1 1 1 1 1 −1 −1 1 1 1 1 1 1 −1 −1 1 1 1 1 1 1 −1 −1 1 1 1 1 1 |
| | −1 −1 −1 −1 −1 1 1 −1 1 1 1 1 1 −1 −1 1 −1 −1 −1 −1 −1 1 1 −1 1 1 1 1 1 −1 −1 |
| | 1 −1 −1 −1 −1 −1 1 1 −1 1 1 1 1 1 −1 −1 1 1 1 1 1 1 −1 −1 1 −1 −1 −1 −1 −1 1 1 |
| | −1 −1 1 −1 1 −1 −1 1 1 −1 1 −1 1 −1 −1 1 1 −1 1 −1 1 −1 −1 1 1 −1 1 −1 1 −1 −1 |
| | 1 1 −1 1 −1 1 −1 −1 1 1 −1 1 −1 1 −1 −1 1 1 1 −1 1 −1 1 1 −1 −1 1 −1 1 −1 1 1 |
| | −1 −1 −1 −1 1 1 −1 1 −1 1 1 1 −1 −1 1 −1 1 −1 1 1 −1 −1 1 −1 1 −1 −1 −1 1 1 −1 |
| | 1 −1 1 −1 −1 1 1 −1 1 −1 1 1 1 −1 −1 1 −1 1 −1 −1 −1 1 1 −1 1 −1 1 1 1 −1 −1 1 |
| | −1 1 −1 −1 1 1 −1 −1 −1 −1 −1 −1 1 1 −1 −1 −1 −1 −1 1 −1 −1 1 1 1 1 1 1 −1 −1 |
| | 1 1 1 1 1 −1 1 1 −1 −1 −1 −1 −1 −1 1 1 −1 −1 −1 −1 −1 −1 1 1 −1 −1 −1 −1 −1 |
| | −1 1 1 −1 −1 −1 −1 −1 1 1 1 1 1 −1 −1 1 1 1 1 1 1 −1 −1 1 1 1 1 1 1 −1 −1 1 1 1 |
| | 1 1 1 −1 −1 1 1 1 1 1 1 −1 −1 1 1 1 1 1 1 −1 −1 1 −1 −1 −1 −1 −1 1 1 −1 −1 −1 |
| | −1 −1 −1 1 1 −1 1 −1 1 −1 1 1 −1 −1 −1 1 −1 1 −1 −1 1 1 1 −1 1 −1 1 1 −1 −1 −1 |
| | 1 −1 1 −1 −1 1 1 1 −1 1 −1 1 1 −1 −1 −1 1 −1 1 −1 −1 1 1 −1 1 −1 1 −1 −1 1 1 1 |
| | −1 1 −1 1 1 −1 −1 1 1 −1 −1 1 −1 1 −1 1 1 −1 −1 1 −1 1 −1 −1 −1 1 1 −1 1 −1 1 |
| | −1 −1 1 1 −1 1 −1 1 1 1 −1 −1 1 −1 1 −1 1 1 −1 −1 1 −1 1 −1 1 1 −1 −1 1 −1 1 |
| | −1 1 1 −1 −1 1 −1 1 −1 1 −1 −1 1 1 1 1 1 −1 1 1 −1 −1 −1 −1 −1 −1 1 1 −1 −1 −1 |
| | −1 −1 1 −1 −1 1 1 1 1 1 1 −1 −1 1 1 1 1 1 −1 1 1 −1 −1 −1 −1 −1 1 −1 −1 1 1 1 1 |
| | 1 −1 1 1 −1 −1 −1 −1 −1 1 1 1 1 1 −1 −1 1 1 1 1 1 1 −1 −1 1 1 1 1 1 1 −1 −1 1 1 |
| | 1 1 1 1 −1 −1 1 1 1 1 1 1 −1 −1 1 1 1 1 1 1 −1 −1 1 −1 −1 −1 −1 −1 1 1 −1 −1 −1 |
| | −1 −1 −1 1 1 −1 1 −1 1 −1 1 1 −1 −1 −1 1 −1 1 −1 −1 1 1 1 −1 1 −1 1 1 −1 −1 −1 |
| | 1 −1 1 −1 −1 1 1 1 −1 1 −1 1 1 −1 −1 −1 1 −1 1 −1 −1 1 1 −1 1 −1 1 −1 −1 1 1 1 |
| | −1 1 −1 1 1 −1 −1 1 1 −1 −1 1 −1 1 −1 1 1 −1 −1 1 −1 1 −1 −1 −1 1 1 −1 1 −1 1 |
| | −1 −1 1 1 −1 1 −1 1 1 1 −1 −1 1 −1 1 −1 1 1 −1 −1 1 −1 1 −1 1 1 −1 −1 1 −1 1 |
| | −1 1 1 −1 −1 1 −1 1 −1 1 −1 −1 1 1 1 1 1 −1 1 1 −1 −1 −1 −1 −1 −1 1 1 −1 −1 −1 |
| | −1 −1 1 −1 −1 1 1 1 1 1 1 −1 −1 1 1 1 1 1 −1 1 1 −1 −1 −1 −1 −1 1 −1 −1 1 1 1 1 |
| | 1 −1 1 1 −1 −1 −1 −1 −1 −1 −1 −1 −1 −1 1 1 −1 1 1 1 1 1 −1 −1 1 −1 −1 −1 −1 |
| | −1 1 1 −1 1 1 1 1 1 −1 −1 1 −1 −1 −1 −1 −1 1 1 −1 1 1 1 1 1 −1 −1 1 1 1 1 1 1 −1 |
| | −1 1 −1 −1 −1 −1 −1 1 1 −1 −1 1 −1 1 −1 −1 1 1 −1 1 −1 1 −1 −1 1 1 −1 1 −1 1 |
| | −1 −1 1 1 −1 1 −1 1 −1 −1 1 1 −1 1 −1 1 −1 −1 1 1 −1 1 −1 1 −1 −1 1 1 1 −1 1 |
| | −1 1 1 −1 −1 1 −1 1 −1 1 1 −1 −1 −1 −1 1 1 −1 1 −1 1 1 1 −1 −1 1 −1 1 −1 1 1 |
| | −1 −1 1 −1 1 −1 −1 −1 1 1 −1 1 −1 1 −1 −1 1 1 −1 1 −1 1 1 1 −1 −1 1 −1 1 −1 −1 |
| | −1 1 1 −1 1 −1 1 1 1 −1 −1 1 −1 1 −1 −1 1 1 −1 −1 −1 −1 −1 −1 1 1 −1 −1 −1 −1 |
| | −1 1 −1 −1 1 1 1 1 1 1 −1 −1 1 1 1 1 1 −1 1 1 −1 −1 −1 −1 −1 −1 1 1 −1 −1 −1 |
| | −1 −1 −1 1 1 −1 −1 −1 −1 −1 −1 1 1 −1 −1 −1 −1 −1 −1 −1 −1 −1 −1 1 1 −1 1 1 |
| | 1 1 1 −1 −1 1 −1 −1 −1 −1 −1 1 1 −1 1 1 1 1 1 −1 −1 1 −1 −1 −1 −1 −1 1 1 −1 1 |
| | 1 1 1 1 −1 −1 1 1 1 1 1 1 −1 −1 1 −1 −1 −1 −1 −1 1 1 −1 −1 1 −1 1 −1 −1 1 1 −1 |
| | 1 −1 1 −1 −1 1 1 −1 1 −1 1 −1 −1 1 1 −1 1 −1 1 −1 −1 1 1 −1 1 −1 1 −1 −1 1 1 |
| | −1 1 −1 1 −1 −1 1 1 1 −1 1 −1 1 1 −1 −1 1 −1 1 −1 1 1 −1 −1 −1 −1 1 1 −1 1 −1 |
| | 1 1 1 −1 −1 1 −1 1 −1 1 1 −1 −1 1 −1 1 −1 −1 −1 1 1 −1 1 −1 1 −1 −1 1 1 −1 1 |
| | −1 1 1 1 −1 −1 1 −1 1 −1 −1 −1 1 1 −1 1 −1 1 1 1 −1 −1 1 −1 1 −1 −1 1 1 −1 −1 |
| | −1 −1 −1 −1 1 1 −1 −1 −1 −1 −1 1 −1 −1 1 1 1 1 1 1 −1 −1 1 1 1 1 1 −1 1 1 −1 |
| | −1 −1 −1 −1 −1 1 1 −1 −1 −1 −1 −1 −1 1 1 −1 −1 −1 −1 −1 −1 1 1 −1 −1 −1 −1 |
| | −1 |
| 10 | 1 1 1 −1 1 1 1 −1 1 1 1 −1 1 1 1 −1 1 −1 1 1 1 −1 1 1 1 −1 1 1 1 −1 1 1 1 1 1 −1 1 |
| | 1 1 −1 −1 −1 −1 1 −1 −1 −1 1 1 −1 1 1 1 −1 1 1 −1 1 −1 −1 −1 1 −1 −1 1 1 1 −1 |
| | −1 −1 −1 1 1 1 1 −1 −1 −1 −1 1 1 −1 1 1 −1 1 −1 −1 1 −1 1 1 −1 1 −1 1 1 1 |
| | −1 −1 −1 −1 1 −1 −1 −1 1 1 1 1 −1 1 −1 1 1 −1 1 −1 −1 −1 1 −1 −1 1 −1 1 1 1 1 |
| | 1 −1 1 1 1 −1 1 1 1 −1 1 1 1 −1 −1 1 −1 −1 −1 1 −1 −1 −1 1 −1 −1 −1 1 −1 −1 1 |
| | 1 1 −1 1 1 1 −1 −1 −1 −1 1 −1 −1 −1 1 −1 1 −1 −1 −1 1 −1 −1 1 −1 1 1 1 −1 1 1 |
| | −1 −1 −1 1 1 1 1 −1 −1 −1 −1 1 1 1 1 −1 1 −1 1 1 −1 1 −1 −1 1 −1 1 1 −1 1 −1 |
| | −1 −1 −1 −1 1 1 1 1 −1 1 1 1 −1 −1 −1 −1 1 1 −1 1 1 −1 1 −1 −1 −1 1 −1 −1 1 −1 |
| | 1 1 1 1 1 −1 1 1 1 −1 1 1 1 −1 1 1 1 −1 1 −1 1 1 1 −1 1 1 1 −1 1 1 1 −1 1 1 1 1 1 |
| | −1 1 1 1 −1 −1 −1 −1 1 −1 −1 −1 1 1 −1 1 1 1 −1 1 1 −1 1 −1 −1 −1 1 −1 −1 1 1 |
| | 1 −1 −1 −1 −1 1 1 1 1 −1 −1 −1 −1 1 1 −1 1 1 −1 1 −1 −1 1 −1 1 1 −1 1 −1 −1 1 |
| | 1 1 −1 −1 −1 −1 1 −1 −1 −1 1 1 1 1 −1 1 −1 1 1 −1 1 −1 −1 −1 1 −1 −1 1 −1 1 1 |
| | 1 1 1 −1 1 1 1 −1 1 1 1 −1 1 1 1 −1 −1 1 −1 −1 −1 1 −1 −1 −1 1 −1 −1 −1 1 −1 |
| | −1 1 1 1 −1 1 1 1 −1 −1 −1 −1 1 −1 −1 −1 1 −1 1 −1 −1 −1 1 −1 −1 1 −1 1 1 1 −1 |
| | 1 1 −1 −1 −1 1 1 1 1 −1 −1 −1 −1 1 1 1 1 −1 1 −1 1 1 −1 1 −1 −1 1 −1 1 1 −1 1 |
| | −1 −1 −1 −1 −1 1 1 1 1 −1 1 1 1 −1 −1 −1 −1 1 1 −1 1 1 −1 1 −1 −1 −1 1 −1 −1 1 |
| | −1 1 1 1 1 1 −1 1 1 1 −1 −1 −1 −1 1 −1 −1 −1 1 1 −1 1 1 1 −1 1 1 −1 1 −1 −1 −1 |
| | 1 −1 −1 1 1 1 −1 1 1 1 −1 1 1 1 −1 1 1 1 −1 1 −1 1 1 1 −1 1 1 1 −1 1 1 1 −1 1 1 1 |
| | 1 1 −1 −1 −1 −1 1 −1 −1 −1 1 1 1 1 −1 1 −1 1 1 −1 1 −1 −1 −1 1 −1 −1 1 −1 1 1 |
| | 1 1 1 −1 −1 −1 −1 1 1 1 1 −1 −1 −1 −1 1 1 −1 1 1 −1 1 −1 −1 1 −1 1 1 −1 1 −1 |
| | −1 1 1 1 −1 1 1 1 −1 −1 −1 −1 1 −1 −1 −1 1 −1 1 −1 −1 −1 1 −1 −1 1 −1 1 1 1 −1 |
| | 1 1 1 1 1 −1 1 1 1 −1 1 1 1 −1 1 1 1 −1 −1 1 −1 −1 −1 1 −1 −1 −1 1 −1 −1 −1 1 |
| | −1 −1 −1 −1 −1 1 1 1 1 −1 1 1 1 −1 −1 −1 −1 1 1 −1 1 1 −1 1 −1 −1 −1 1 −1 −1 1 |
| | −1 1 1 −1 −1 −1 1 1 1 1 −1 −1 −1 −1 1 1 1 1 −1 1 −1 1 1 −1 1 −1 −1 1 −1 1 1 −1 |
| | 1 −1 −1 −1 −1 −1 1 −1 −1 −1 1 1 1 1 −1 1 1 1 −1 −1 1 −1 −1 −1 1 −1 −1 1 −1 1 1 |
| | 1 −1 1 1 −1 −1 −1 1 −1 −1 −1 1 −1 −1 −1 1 −1 −1 −1 1 −1 1 −1 −1 −1 1 −1 −1 |
| | −1 1 −1 −1 −1 1 −1 −1 −1 −1 −1 1 1 1 1 −1 1 1 1 −1 −1 −1 −1 1 −1 1 −1 −1 1 −1 |
| | 1 1 1 −1 1 1 −1 1 −1 −1 −1 −1 −1 1 1 1 1 −1 −1 −1 −1 1 1 1 1 −1 −1 1 −1 −1 1 |
| | −1 1 1 −1 1 −1 −1 1 −1 1 1 −1 −1 −1 1 1 −1 −1 1 1 1 1 −1 1 1 1 −1 1 −1 1 1 1 |
| | −1 1 1 −1 1 −1 −1 −1 1 −1 −1 −1 −1 −1 1 −1 −1 −1 1 −1 −1 −1 1 −1 −1 −1 1 1 |
| | −1 1 1 1 −1 1 1 1 −1 1 1 1 −1 1 1 1 1 1 −1 −1 −1 −1 1 −1 −1 −1 1 1 1 1 −1 −1 1 |
| | −1 −1 1 −1 1 1 1 −1 1 1 −1 1 −1 −1 1 1 1 −1 −1 −1 −1 1 1 1 1 −1 −1 −1 −1 1 −1 |
| | 1 −1 −1 1 −1 1 1 −1 1 −1 −1 1 −1 1 1 1 1 1 −1 −1 −1 −1 1 1 1 1 −1 −1 −1 −1 1 1 |
| | −1 1 1 −1 1 −1 −1 1 −1 1 1 −1 1 −1 −1 −1 −1 −1 1 1 1 1 −1 1 1 1 −1 −1 −1 −1 1 |
| | −1 1 −1 −1 1 −1 1 1 1 −1 1 1 −1 1 −1 −1 1 1 1 −1 1 1 1 −1 1 1 1 −1 1 1 1 −1 1 −1 |
| | 1 1 1 −1 1 1 1 −1 1 1 1 −1 1 1 −1 −1 −1 1 −1 −1 −1 1 1 1 1 −1 1 1 1 −1 −1 1 −1 |
| | −1 −1 1 −1 −1 1 −1 1 1 1 −1 1 1 1 1 1 −1 −1 −1 −1 1 1 1 1 −1 −1 −1 −1 1 −1 1 |
| | −1 −1 1 −1 1 1 −1 1 −1 −1 1 −1 1 1 −1 −1 −1 1 1 1 1 −1 1 1 1 −1 −1 −1 −1 1 1 |
| | −1 1 1 −1 1 −1 −1 −1 1 −1 −1 1 −1 1 1 −1 −1 −1 1 −1 −1 −1 1 −1 −1 −1 1 −1 −1 |
| | −1 1 1 −1 1 1 1 −1 1 1 1 −1 1 1 1 −1 1 1 1 1 1 −1 1 1 1 −1 −1 −1 −1 1 −1 −1 −1 1 |
| | −1 1 −1 −1 −1 1 −1 −1 1 −1 1 1 1 −1 1 1 1 1 1 −1 −1 −1 −1 1 1 1 1 −1 −1 −1 −1 |
| | 1 1 −1 1 1 −1 1 −1 −1 1 −1 1 1 −1 1 −1 −1 −1 −1 −1 1 1 1 1 −1 1 1 1 −1 −1 −1 |
| | −1 1 −1 1 −1 −1 1 −1 1 1 1 −1 1 1 −1 1 −1 −1 1 1 1 −1 1 1 1 −1 1 1 1 −1 1 1 1 −1 |
| | 1 −1 1 1 1 −1 1 1 1 −1 1 1 1 −1 1 1 −1 −1 −1 1 −1 −1 −1 1 1 1 1 −1 1 1 1 −1 −1 1 |
| | −1 −1 −1 1 −1 −1 1 −1 1 1 1 −1 1 1 1 1 1 −1 −1 −1 −1 1 1 1 1 −1 −1 −1 −1 1 −1 |
| | 1 −1 −1 1 −1 1 1 −1 1 −1 −1 1 −1 1 1 −1 −1 −1 1 1 1 1 −1 1 1 1 −1 −1 −1 −1 1 1 |
| | −1 1 1 −1 1 −1 −1 −1 1 −1 −1 1 −1 1 1 −1 −1 −1 1 −1 −1 −1 1 −1 −1 −1 1 −1 −1 |
| | −1 1 1 −1 1 1 1 −1 1 1 1 −1 1 1 1 −1 1 1 1 1 1 −1 1 1 1 −1 −1 −1 −1 1 −1 −1 −1 1 |
| | −1 1 −1 −1 −1 1 −1 −1 1 −1 1 1 1 −1 1 1 1 1 1 −1 −1 −1 −1 1 −1 −1 −1 1 1 1 1 |
| | −1 1 −1 1 1 −1 1 −1 −1 −1 1 −1 −1 1 −1 1 1 −1 −1 −1 1 1 1 1 −1 −1 −1 −1 1 1 1 |
| | 1 −1 −1 1 −1 −1 1 −1 1 1 −1 1 −1 −1 1 −1 1 1 1 1 1 −1 1 1 1 −1 −1 −1 −1 1 −1 |
| | −1 −1 1 1 −1 1 1 1 −1 1 1 −1 1 −1 −1 −1 1 −1 −1 −1 −1 −1 1 −1 −1 −1 1 −1 −1 |
| | −1 1 −1 −1 −1 1 −1 1 −1 −1 −1 1 −1 −1 −1 1 −1 −1 −1 1 −1 −1 1 1 1 −1 −1 −1 |
| | −1 1 −1 −1 −1 1 1 1 1 −1 −1 1 −1 −1 1 −1 1 1 1 −1 1 1 −1 1 −1 −1 −1 −1 −1 1 1 |
| | 1 1 −1 −1 −1 −1 1 1 1 1 −1 1 −1 1 1 −1 1 −1 −1 1 −1 1 1 −1 1 −1 −1 −1 −1 −1 1 |
| | −1 −1 −1 1 1 1 1 −1 1 1 1 −1 1 −1 1 1 1 −1 1 1 −1 1 −1 −1 −1 1 −1 −1 1 1 1 −1 1 |
| | 1 1 −1 1 1 1 −1 1 1 1 −1 −1 1 −1 −1 −1 1 −1 −1 −1 1 −1 −1 −1 1 −1 −1 −1 −1 −1 |
| | 1 1 1 1 −1 1 1 1 −1 −1 −1 −1 1 −1 1 −1 −1 1 −1 1 1 1 −1 1 1 −1 1 −1 −1 1 1 1 −1 |
| | −1 −1 −1 1 1 1 1 −1 −1 −1 −1 1 1 −1 1 1 −1 1 −1 −1 1 −1 1 1 −1 1 −1 −1 −1 −1 |
| | −1 1 −1 −1 −1 1 1 1 1 −1 1 1 1 −1 −1 1 −1 −1 −1 1 −1 −1 1 −1 1 1 1 −1 1 1 1 1 1 |
| | −1 1 1 1 −1 1 1 1 −1 1 1 1 −1 1 −1 1 1 1 −1 1 1 1 −1 1 1 1 −1 1 1 −1 −1 −1 1 1 1 |
| | 1 −1 1 1 1 −1 −1 −1 −1 1 1 −1 1 1 −1 1 −1 −1 −1 1 −1 −1 1 −1 1 1 1 1 1 −1 −1 |
| | −1 −1 1 1 1 1 −1 −1 −1 −1 1 −1 1 −1 −1 1 −1 1 1 −1 1 −1 −1 1 −1 1 1 1 1 1 −1 1 |
| | 1 1 −1 −1 −1 −1 1 −1 −1 −1 1 −1 1 −1 −1 −1 1 −1 −1 1 −1 1 1 1 −1 1 1 −1 −1 −1 |
| | 1 −1 −1 −1 1 −1 −1 −1 1 −1 −1 −1 1 1 −1 1 1 1 −1 1 1 1 −1 1 1 1 −1 1 1 1 1 1 −1 |
| | 1 1 1 −1 1 1 1 −1 1 1 1 −1 1 −1 1 1 1 −1 1 1 1 −1 1 1 1 −1 1 1 1 1 1 −1 1 1 1 −1 |
| | −1 −1 −1 1 −1 −1 −1 1 1 −1 1 1 1 1 1 1 −1 1 −1 −1 −1 1 −1 −1 1 1 1 −1 −1 −1 |
| | −1 1 1 1 1 −1 −1 −1 −1 1 1 −1 1 1 −1 1 −1 −1 1 −1 1 1 −1 1 −1 −1 1 1 1 −1 −1 |
| | −1 −1 1 −1 −1 −1 1 1 1 1 −1 1 −1 1 1 −1 1 −1 −1 −1 1 −1 −1 1 −1 1 1 1 1 1 −1 1 |
| | 1 1 −1 1 1 1 −1 1 1 1 −1 −1 1 −1 −1 −1 1 −1 −1 −1 1 −1 −1 −1 1 −1 −1 1 1 1 −1 |
| | 1 1 1 −1 −1 −1 −1 1 −1 −1 −1 1 −1 1 −1 −1 −1 1 −1 −1 1 −1 1 1 1 −1 1 1 −1 −1 |
| | −1 1 1 1 1 −1 −1 −1 −1 1 1 1 1 −1 1 −1 1 1 −1 1 −1 −1 1 −1 1 1 −1 1 −1 −1 −1 |
| | −1 −1 1 1 1 1 −1 1 1 1 −1 −1 −1 −1 1 1 −1 1 1 −1 1 −1 −1 −1 1 −1 −1 1 −1 1 1 |
| | −1 −1 −1 1 −1 −1 −1 1 −1 −1 −1 1 −1 −1 −1 1 −1 1 −1 −1 −1 1 −1 −1 −1 1 −1 −1 |
| | −1 1 −1 −1 −1 −1 −1 1 −1 −1 −1 1 1 1 1 −1 1 1 1 −1 −1 1 −1 −1 −1 1 −1 −1 1 −1 |
| | 1 1 1 −1 1 −1 −1 −1 1 1 1 1 −1 −1 −1 −1 1 1 1 1 −1 −1 1 −1 −1 1 −1 1 1 −1 1 |
| | −1 −1 1 −1 1 1 −1 −1 −1 1 1 1 1 −1 1 1 1 −1 −1 −1 −1 1 −1 1 −1 −1 1 −1 1 1 1 |
| | −1 1 1 −1 1 −1 −1 −1 −1 −1 1 −1 −1 −1 1 −1 −1 −1 1 −1 −1 −1 1 1 −1 1 1 1 −1 1 |
| | 1 1 −1 1 1 1 −1 1 1 −1 −1 −1 1 −1 −1 −1 1 1 1 1 −1 1 1 1 −1 1 −1 1 1 1 −1 1 1 −1 |
| | 1 −1 −1 −1 1 −1 −1 1 1 1 −1 −1 −1 −1 1 1 1 1 −1 −1 −1 −1 1 −1 1 −1 −1 1 −1 1 1 |
| | −1 1 −1 −1 1 −1 1 1 1 1 1 −1 −1 −1 −1 1 −1 −1 −1 1 1 1 1 −1 −1 1 −1 1 −1 1 |
| | 1 1 −1 1 1 −1 1 −1 −1 1 1 1 −1 1 1 1 −1 −1 −1 −1 1 −1 −1 −1 1 1 −1 1 1 1 −1 1 1 |
| | −1 1 −1 −1 −1 1 −1 −1 1 1 1 −1 1 1 1 −1 1 1 1 −1 1 1 1 −1 1 −1 1 1 1 −1 1 1 1 −1 |
| | 1 1 1 −1 1 1 1 1 1 −1 −1 −1 −1 1 −1 −1 −1 1 1 1 1 −1 1 −1 1 1 −1 1 −1 −1 −1 1 |
| | −1 −1 1 −1 1 1 1 1 1 −1 −1 −1 −1 1 1 1 1 −1 −1 −1 −1 1 1 −1 1 1 −1 1 −1 −1 1 |
| | −1 1 1 −1 1 −1 −1 1 1 1 −1 1 1 1 −1 −1 −1 −1 1 −1 −1 −1 1 −1 1 −1 −1 −1 1 −1 |
| | −1 1 −1 1 1 1 −1 1 1 1 1 1 −1 1 1 1 −1 1 1 1 −1 1 1 1 −1 −1 1 −1 −1 −1 1 −1 −1 |
| | −1 1 −1 −1 −1 1 −1 −1 −1 −1 −1 1 1 1 1 −1 1 1 1 −1 −1 −1 −1 1 1 −1 1 1 −1 1 −1 |
| | −1 −1 1 −1 −1 1 −1 1 1 −1 −1 −1 1 1 1 1 −1 −1 −1 −1 1 1 1 1 −1 1 −1 1 1 −1 1 |
| | −1 −1 1 −1 1 1 −1 1 −1 −1 1 1 1 −1 1 1 1 −1 −1 −1 −1 1 −1 −1 −1 1 1 −1 1 1 1 |
| | −1 1 1 −1 1 −1 −1 −1 1 −1 −1 1 1 1 −1 1 1 1 −1 1 1 1 −1 1 1 1 −1 1 −1 1 1 1 −1 1 |
| | 1 1 −1 1 1 1 −1 1 1 1 1 1 −1 −1 −1 −1 1 −1 −1 −1 1 1 1 1 −1 1 −1 1 1 −1 1 −1 −1 |
| | −1 1 −1 −1 1 −1 1 1 1 1 1 −1 −1 −1 −1 1 1 1 1 −1 −1 −1 −1 1 1 −1 1 1 −1 1 −1 |
| | −1 1 −1 1 1 −1 1 −1 −1 1 1 1 −1 1 1 1 −1 −1 −1 −1 1 −1 −1 −1 1 −1 1 −1 −1 −1 1 |
| | −1 −1 1 −1 1 1 1 −1 1 1 1 1 1 −1 1 1 1 −1 1 1 1 −1 1 1 1 −1 −1 1 −1 −1 −1 1 −1 |
| | −1 −1 1 −1 −1 −1 1 −1 −1 −1 −1 −1 1 1 1 1 −1 1 1 1 −1 −1 −1 −1 1 1 −1 1 1 −1 1 |
| | −1 −1 −1 1 −1 −1 1 −1 1 1 −1 −1 −1 1 1 1 1 −1 −1 −1 −1 1 1 1 1 −1 1 −1 1 1 −1 |
| | 1 −1 −1 1 −1 1 1 −1 1 −1 −1 1 1 1 −1 −1 −1 −1 1 1 1 1 −1 −1 −1 −1 1 1 −1 1 1 |
| | −1 1 −1 −1 1 −1 1 1 −1 1 −1 −1 −1 −1 −1 1 1 1 1 −1 1 1 1 −1 −1 −1 −1 1 −1 1 −1 |
| | −1 1 −1 1 1 1 −1 1 1 −1 1 −1 −1 1 1 1 −1 1 1 1 −1 1 1 1 −1 1 1 1 −1 1 −1 1 1 1 |
| | −1 1 1 1 −1 1 1 1 −1 1 1 −1 −1 −1 1 −1 −1 −1 1 1 1 1 −1 1 1 1 −1 −1 1 −1 −1 −1 |
| | 1 −1 −1 1 −1 1 1 1 −1 1 1 1 1 1 −1 −1 −1 −1 1 1 1 1 −1 −1 −1 −1 1 −1 1 −1 −1 1 |
| | −1 1 1 −1 1 −1 −1 1 −1 1 1 −1 −1 −1 1 1 1 1 −1 1 1 1 −1 −1 −1 −1 1 1 −1 1 1 −1 |
| | 1 −1 −1 −1 1 −1 −1 1 −1 1 1 −1 −1 −1 1 −1 −1 −1 1 −1 −1 −1 1 −1 −1 −1 1 1 −1 |
| | 1 1 1 −1 1 1 1 −1 1 1 1 −1 1 1 1 1 1 −1 1 1 1 −1 −1 −1 −1 1 −1 −1 −1 1 −1 1 −1 |
| | −1 −1 1 −1 −1 1 −1 1 1 1 −1 1 1 −1 −1 −1 1 1 1 1 −1 −1 −1 −1 1 1 1 1 −1 −1 1 |
| | −1 −1 1 −1 1 1 −1 1 −1 −1 1 −1 1 1 1 1 1 −1 −1 −1 −1 1 −1 −1 −1 1 1 1 1 −1 1 |
| | −1 1 1 −1 1 −1 −1 −1 1 −1 −1 1 −1 1 1 −1 −1 −1 1 −1 −1 −1 1 −1 −1 −1 1 −1 −1 |
| | −1 1 −1 1 −1 −1 −1 1 −1 −1 −1 1 −1 −1 −1 1 −1 −1 1 1 1 −1 1 1 1 −1 −1 −1 −1 1 |
| | −1 −1 −1 1 1 −1 1 1 1 −1 1 1 −1 1 −1 −1 −1 1 −1 −1 −1 −1 −1 1 1 1 −1 −1 −1 |
| | −1 1 1 1 1 −1 1 −1 1 1 −1 1 −1 −1 1 −1 1 1 −1 1 −1 −1 1 1 1 −1 −1 −1 −1 1 −1 |
| | −1 −1 1 1 1 1 −1 −1 1 −1 −1 1 −1 1 1 1 −1 1 1 −1 1 −1 −1 1 1 1 −1 1 1 1 −1 1 1 1 |
| | −1 1 1 1 −1 −1 1 −1 −1 −1 1 −1 −1 −1 1 −1 −1 −1 1 −1 −1 −1 −1 −1 1 −1 −1 −1 |
| | 1 1 1 1 −1 1 1 1 −1 1 −1 1 1 1 −1 1 1 −1 1 −1 −1 −1 1 −1 −1 1 1 1 −1 −1 −1 −1 1 |
| | −1 −1 −1 1 1 1 1 −1 1 −1 1 1 −1 1 −1 −1 −1 1 −1 −1 1 −1 1 1 −1 −1 −1 1 1 1 1 |
| | −1 −1 −1 −1 1 1 1 1 −1 −1 1 −1 −1 1 −1 1 1 −1 1 −1 −1 1 −1 1 1 1 1 1 −1 1 1 1 |
| | −1 −1 −1 −1 1 −1 −1 −1 1 1 −1 1 1 1 −1 1 1 −1 1 −1 −1 −1 1 −1 −1 −1 −1 −1 1 |
| | −1 −1 −1 1 −1 −1 −1 1 −1 −1 −1 1 −1 1 −1 −1 −1 1 −1 −1 −1 1 −1 −1 −1 1 −1 −1 |
| | 1 1 1 −1 −1 −1 −1 1 −1 −1 −1 1 1 1 1 −1 −1 1 −1 −1 1 −1 1 1 1 −1 1 1 −1 1 −1 |
| | −1 −1 −1 −1 1 1 1 1 −1 −1 −1 −1 1 1 1 1 −1 1 −1 1 1 −1 1 −1 −1 1 −1 1 1 −1 1 |
| | −1 −1 −1 −1 −1 1 −1 −1 −1 1 1 1 1 −1 1 1 1 −1 1 −1 1 1 1 −1 1 1 −1 1 −1 −1 −1 |
| | 1 −1 −1 1 1 1 −1 1 1 1 −1 1 1 1 −1 1 1 1 −1 −1 1 −1 −1 −1 1 −1 −1 −1 1 −1 −1 |
| | −1 1 −1 −1 1 1 1 −1 −1 −1 −1 1 −1 −1 −1 1 1 1 1 −1 1 −1 1 1 −1 1 −1 −1 −1 1 −1 |
| | −1 1 −1 1 1 −1 −1 −1 1 1 1 1 −1 −1 −1 −1 1 1 1 1 −1 −1 1 −1 −1 1 −1 1 1 −1 1 |
| | −1 −1 1 −1 1 1 1 1 1 −1 1 1 1 −1 −1 −1 −1 1 −1 −1 −1 1 1 −1 1 1 1 −1 1 1 −1 1 |
| | −1 −1 −1 1 −1 −1 −1 −1 −1 1 −1 −1 −1 1 −1 −1 −1 1 −1 −1 −1 1 −1 1 −1 −1 −1 1 |
| | −1 −1 −1 1 −1 −1 −1 1 −1 −1 1 1 1 −1 −1 −1 −1 1 −1 −1 −1 1 1 1 1 −1 −1 1 −1 |
| | −1 1 −1 1 1 1 −1 1 1 −1 1 −1 −1 −1 −1 −1 1 1 1 1 −1 −1 −1 −1 1 1 1 1 −1 1 −1 1 |
| | 1 −1 1 −1 −1 1 −1 1 1 −1 1 −1 −1 −1 −1 −1 1 −1 −1 −1 1 1 1 1 −1 1 1 1 −1 1 −1 |
| | 1 1 1 −1 1 1 −1 1 −1 −1 −1 1 −1 −1 1 1 1 −1 1 1 1 −1 1 1 1 −1 1 1 1 −1 −1 1 −1 |
| | −1 −1 1 −1 −1 −1 1 −1 −1 −1 1 −1 −1 −1 −1 −1 1 −1 −1 −1 1 −1 −1 −1 1 −1 −1 |
| | −1 1 −1 1 −1 −1 −1 1 −1 −1 −1 1 −1 −1 −1 1 −1 −1 −1 −1 −1 1 −1 −1 −1 1 1 1 1 |
| | −1 1 1 1 −1 −1 1 −1 −1 −1 1 −1 −1 1 −1 1 1 1 −1 1 1 −1 −1 −1 1 1 1 1 −1 −1 −1 |
| | −1 1 1 1 1 −1 −1 1 −1 −1 1 −1 1 1 −1 1 −1 −1 1 −1 1 1 −1 −1 −1 1 1 1 1 −1 1 1 1 |
| | −1 −1 −1 −1 1 −1 1 −1 −1 1 −1 1 1 1 −1 1 1 −1 1 −1 −1 −1 −1 −1 1 −1 −1 −1 1 |
| | −1 −1 −1 1 −1 −1 −1 1 1 −1 1 1 1 −1 1 1 1 −1 1 1 1 −1 1 1 −1 −1 −1 1 −1 −1 −1 |
| | 1 1 1 1 −1 1 1 1 −1 1 −1 1 1 1 −1 1 1 −1 1 −1 −1 −1 1 −1 −1 1 1 1 −1 −1 −1 −1 1 |
| | 1 1 1 −1 −1 −1 −1 1 −1 1 −1 −1 1 −1 1 1 −1 1 −1 −1 1 −1 1 1 1 1 1 −1 −1 −1 −1 |
| | 1 −1 −1 −1 1 1 1 1 −1 −1 1 −1 −1 1 −1 1 1 1 −1 1 1 −1 1 −1 −1 −1 −1 −1 1 −1 −1 |
| | −1 1 −1 −1 −1 1 −1 −1 −1 1 −1 1 −1 −1 −1 1 −1 −1 −1 1 −1 −1 −1 1 −1 −1 −1 −1 |
| | −1 1 −1 −1 −1 1 1 1 1 −1 1 1 1 −1 −1 1 −1 −1 −1 1 −1 −1 1 −1 1 1 1 −1 1 1 −1 |
| | −1 −1 1 1 1 1 −1 −1 −1 −1 1 1 1 1 −1 −1 1 −1 −1 1 −1 1 1 −1 1 −1 −1 1 −1 1 1 |
| | −1 −1 −1 1 1 1 1 −1 1 1 1 −1 −1 −1 −1 1 −1 1 −1 −1 1 −1 1 1 1 −1 1 1 −1 1 −1 |
| | −1 −1 −1 −1 1 −1 −1 −1 1 −1 −1 −1 1 −1 −1 −1 1 1 −1 1 1 1 −1 1 1 1 −1 1 1 1 −1 |
| | 1 1 −1 −1 −1 1 −1 −1 −1 1 1 1 1 −1 1 1 1 −1 1 −1 1 1 1 −1 1 1 −1 1 −1 −1 −1 1 |
| | −1 −1 1 1 1 −1 −1 −1 −1 1 1 1 1 −1 −1 −1 −1 1 −1 1 −1 −1 1 −1 1 1 −1 1 −1 −1 1 |
| | −1 1 1 1 1 1 −1 −1 −1 −1 1 −1 −1 −1 1 1 1 1 −1 −1 1 −1 −1 1 −1 1 1 1 −1 1 1 −1 |
| | 1 −1 −1 −1 −1 −1 1 −1 −1 −1 1 1 1 1 −1 1 1 1 −1 −1 1 −1 −1 −1 1 −1 −1 1 −1 1 1 |
| | 1 −1 1 1 −1 −1 −1 1 −1 −1 −1 1 −1 −1 −1 1 −1 −1 −1 1 −1 1 −1 −1 −1 1 −1 −1 |
| | −1 1 −1 −1 −1 1 −1 −1 −1 −1 −1 1 1 1 1 −1 1 1 1 −1 −1 −1 −1 1 −1 1 −1 −1 1 −1 |
| | 1 1 1 −1 1 1 −1 1 −1 −1 −1 −1 −1 1 1 1 1 −1 −1 −1 −1 1 1 1 1 −1 −1 1 −1 −1 1 |
| | −1 1 1 −1 1 −1 −1 1 −1 1 1 −1 −1 −1 1 −1 −1 −1 1 1 1 1 −1 1 1 1 −1 1 −1 1 1 1 |
| | −1 1 1 −1 1 −1 −1 −1 1 −1 −1 −1 −1 −1 1 −1 −1 −1 1 −1 −1 −1 1 −1 −1 −1 1 1 |
| | −1 1 1 1 −1 1 1 1 −1 1 1 1 −1 1 1 1 1 1 −1 −1 −1 −1 1 −1 −1 −1 1 1 1 1 −1 −1 1 |
| | −1 −1 1 −1 1 1 1 −1 1 1 −1 1 −1 −1 1 1 1 −1 −1 −1 −1 1 1 1 1 −1 −1 −1 −1 1 −1 |
| | 1 −1 −1 1 −1 1 1 −1 1 −1 −1 1 −1 1 1 1 1 1 −1 1 1 1 −1 −1 −1 −1 1 −1 −1 −1 1 1 |
| | −1 1 1 1 −1 1 1 −1 1 −1 −1 −1 1 −1 −1 1 1 1 −1 1 1 1 −1 1 1 1 −1 1 1 1 −1 1 −1 1 |
| | 1 1 −1 1 1 1 −1 1 1 1 −1 1 1 1 1 1 −1 −1 −1 −1 1 −1 −1 −1 1 1 1 1 −1 1 −1 1 1 −1 |
| | 1 −1 −1 −1 1 −1 −1 1 −1 1 1 1 1 1 −1 −1 −1 −1 1 1 1 1 −1 −1 −1 −1 1 1 −1 1 1 |
| | −1 1 −1 −1 1 −1 1 1 −1 1 −1 −1 1 1 1 −1 1 1 1 −1 −1 −1 −1 1 −1 −1 −1 1 −1 1 −1 |
| | −1 −1 1 −1 −1 1 −1 1 1 1 −1 1 1 1 1 1 −1 1 1 1 −1 1 1 1 −1 1 1 1 −1 −1 1 −1 −1 |
| | −1 1 −1 −1 −1 1 −1 −1 −1 1 −1 −1 −1 −1 −1 1 1 1 1 −1 1 1 1 −1 −1 −1 −1 1 1 −1 |
| | 1 1 −1 1 −1 −1 −1 1 −1 −1 1 −1 1 1 −1 −1 −1 1 1 1 1 −1 −1 −1 −1 1 1 1 1 −1 1 |
| | −1 1 1 −1 1 −1 −1 1 −1 1 1 −1 1 −1 −1 −1 −1 −1 1 1 1 1 −1 −1 −1 −1 1 1 1 1 −1 |
| | −1 1 −1 −1 1 −1 1 1 −1 1 −1 −1 1 −1 1 1 1 1 1 −1 −1 −1 −1 1 −1 −1 −1 1 1 1 1 |
| | −1 1 −1 1 1 −1 1 −1 −1 −1 1 −1 −1 1 −1 1 1 −1 −1 −1 1 −1 −1 −1 1 −1 −1 −1 1 |
| | −1 −1 −1 1 −1 1 −1 −1 −1 1 −1 −1 −1 1 −1 −1 −1 1 −1 −1 1 1 1 −1 1 1 1 −1 −1 |
| | −1 −1 1 −1 −1 −1 1 1 −1 1 1 1 −1 1 1 −1 1 −1 −1 −1 1 −1 −1 −1 −1 −1 1 1 1 1 −1 |
| | −1 −1 −1 1 1 1 1 −1 1 −1 1 1 −1 1 −1 −1 1 −1 1 1 −1 1 −1 −1 1 1 1 −1 −1 −1 −1 |
| | 1 −1 −1 −1 1 1 1 1 −1 −1 1 −1 −1 1 −1 1 1 1 −1 1 1 −1 1 −1 −1 1 1 1 −1 1 1 1 −1 |
| | 1 1 1 −1 1 1 1 −1 −1 1 −1 −1 −1 1 −1 −1 −1 1 −1 −1 −1 1 −1 −1 −1 −1 −1 1 −1 |
| | −1 −1 1 1 1 1 −1 1 1 1 −1 1 −1 1 1 1 −1 1 1 −1 1 −1 −1 −1 1 −1 −1 −1 −1 −1 1 1 |
| | 1 1 −1 −1 −1 −1 1 1 1 1 −1 −1 1 −1 −1 1 −1 1 1 −1 1 −1 −1 1 −1 1 1 1 1 1 −1 −1 |
| | −1 −1 1 −1 −1 −1 1 1 1 1 −1 1 −1 1 1 −1 1 −1 −1 −1 1 −1 −1 1 −1 1 1 −1 −1 −1 1 |
| | −1 −1 −1 1 −1 −1 −1 1 −1 −1 −1 1 −1 1 −1 −1 −1 1 −1 −1 −1 1 −1 −1 −1 1 −1 −1 |
| | 1 1 1 −1 1 1 1 −1 −1 −1 −1 1 −1 −1 −1 1 1 −1 1 1 1 −1 1 1 −1 1 −1 −1 −1 1 −1 |
| | −1 −1 −1 −1 1 1 1 1 −1 −1 −1 −1 1 1 1 1 −1 1 −1 1 1 −1 1 −1 −1 1 −1 1 1 −1 1 |
| | −1 −1 1 1 1 −1 −1 −1 −1 1 −1 −1 −1 1 1 1 1 −1 −1 1 −1 −1 1 −1 1 1 1 −1 1 1 −1 |
| | 1 −1 −1 1 1 1 −1 1 1 1 −1 1 1 1 −1 1 1 1 −1 −1 1 −1 −1 −1 1 −1 −1 −1 1 −1 −1 |
| | −1 1 −1 −1 −1 −1 −1 1 −1 −1 −1 1 1 1 1 −1 1 1 1 −1 1 −1 1 1 1 −1 1 1 −1 1 −1 |
| | −1 −1 1 −1 −1 −1 −1 −1 1 1 1 1 −1 1 1 1 −1 −1 −1 −1 1 −1 1 −1 −1 1 −1 1 1 1 −1 |
| | 1 1 −1 1 −1 −1 1 1 1 −1 −1 −1 −1 1 1 1 1 −1 −1 −1 −1 1 1 −1 1 1 −1 1 −1 −1 1 |
| | −1 1 1 −1 1 −1 −1 −1 −1 −1 1 −1 −1 −1 1 1 1 1 −1 1 1 1 −1 −1 1 −1 −1 −1 1 −1 |
| | −1 1 −1 1 1 1 −1 1 1 1 1 1 −1 1 1 1 −1 1 1 1 −1 1 1 1 −1 1 −1 1 1 1 −1 1 1 1 −1 1 |
| | 1 1 −1 1 1 −1 −1 −1 1 1 1 1 −1 1 1 1 −1 −1 −1 −1 1 1 −1 1 1 −1 1 −1 −1 −1 1 −1 |
| | −1 1 −1 1 1 1 1 1 −1 −1 −1 −1 1 1 1 1 −1 −1 −1 −1 1 −1 1 −1 −1 1 −1 1 1 −1 1 |
| | −1 −1 1 −1 1 1 1 1 1 −1 1 1 1 −1 −1 −1 −1 1 −1 −1 −1 1 −1 1 −1 −1 −1 1 −1 −1 1 |
| | −1 1 1 1 −1 1 1 −1 −1 −1 1 −1 −1 −1 1 −1 −1 −1 1 −1 −1 −1 1 1 −1 1 1 1 −1 1 1 |
| | 1 −1 1 1 1 −1 1 1 1 1 1 −1 −1 −1 −1 1 −1 −1 −1 1 1 1 1 −1 1 −1 1 1 −1 1 −1 −1 |
| | −1 1 −1 −1 1 −1 1 1 −1 −1 −1 1 1 1 1 −1 −1 −1 −1 1 1 1 1 −1 −1 1 −1 −1 1 −1 1 |
| | 1 −1 1 −1 −1 1 −1 1 1 1 1 1 −1 1 1 1 −1 −1 −1 −1 1 −1 −1 −1 1 1 −1 1 1 1 −1 1 1 |
| | −1 1 −1 −1 −1 1 −1 −1 −1 −1 −1 1 −1 −1 −1 1 −1 −1 −1 1 −1 −1 −1 1 −1 1 −1 −1 |
| | −1 1 −1 −1 −1 1 −1 −1 −1 1 −1 −1 1 1 1 −1 −1 −1 −1 1 −1 −1 −1 1 1 1 1 −1 −1 1 |
| | −1 −1 1 −1 1 1 1 −1 1 1 −1 1 −1 −1 −1 −1 −1 1 1 1 1 −1 −1 −1 −1 1 1 1 1 −1 1 |
| | −1 1 1 −1 1 −1 −1 1 −1 1 1 −1 1 −1 −1 −1 −1 −1 1 −1 −1 −1 1 1 1 1 −1 1 1 1 −1 |
| | 1 −1 1 1 1 −1 1 1 −1 1 −1 −1 −1 1 −1 −1 1 1 1 −1 1 1 1 −1 1 1 1 −1 1 1 1 −1 −1 1 |
| | −1 −1 −1 1 −1 −1 −1 1 −1 −1 −1 1 −1 −1 1 1 −1 1 1 −1 1 1 1 −1 1 1 1 −1 1 |
| | −1 1 1 1 −1 1 1 1 −1 1 1 1 −1 1 1 1 1 1 −1 1 1 1 −1 −1 −1 −1 1 −1 −1 −1 1 1 −1 1 |
| | 1 1 −1 1 1 −1 1 −1 −1 −1 1 −1 −1 1 1 1 −1 −1 −1 −1 1 1 1 1 −1 −1 −1 −1 1 1 −1 |
| | 1 1 −1 1 −1 −1 1 −1 1 1 −1 1 −1 −1 1 1 1 −1 −1 −1 −1 1 −1 −1 −1 1 1 1 1 −1 1 |
| | −1 1 1 −1 1 −1 −1 −1 1 −1 −1 1 −1 1 1 1 1 1 −1 1 1 1 −1 1 1 1 −1 1 1 1 −1 −1 1 |
| | −1 −1 −1 1 −1 −1 −1 1 −1 −1 −1 1 −1 −1 1 1 1 −1 1 1 1 −1 −1 −1 −1 1 −1 −1 −1 |
| | 1 −1 1 −1 −1 −1 1 −1 −1 1 −1 1 1 1 −1 1 1 −1 −1 −1 1 1 1 1 −1 −1 −1 −1 1 1 1 1 |
| | −1 1 −1 1 1 −1 1 −1 −1 1 −1 1 1 −1 1 −1 −1 −1 −1 −1 1 1 1 1 −1 1 1 1 −1 −1 −1 |
| | −1 1 1 −1 1 1 −1 1 −1 −1 −1 1 −1 −1 1 −1 1 1 −1 −1 −1 1 −1 −1 −1 1 −1 −1 −1 1 |
| | −1 −1 −1 1 −1 1 −1 −1 −1 1 −1 −1 −1 1 −1 −1 −1 1 −1 −1 −1 −1 −1 1 −1 −1 −1 1 |
| | 1 1 1 −1 1 1 1 −1 −1 1 −1 −1 −1 1 −1 −1 1 −1 1 1 1 −1 1 1 −1 −1 −1 1 1 1 1 −1 |
| | −1 −1 −1 1 1 1 1 −1 −1 1 −1 −1 1 −1 1 1 −1 1 −1 −1 1 −1 1 1 −1 −1 −1 1 1 1 1 |
| | −1 1 1 1 −1 −1 −1 −1 1 −1 1 −1 −1 1 −1 1 1 1 −1 1 1 −1 1 −1 −1 −1 −1 −1 1 −1 |
| | −1 −1 1 −1 −1 −1 1 −1 −1 −1 1 1 −1 1 1 1 −1 1 1 1 −1 1 1 1 −1 1 1 −1 −1 −1 1 |
| | −1 −1 −1 1 1 1 1 −1 1 1 1 −1 1 −1 1 1 1 −1 1 1 −1 1 −1 −1 −1 1 −1 −1 1 1 1 −1 |
| | −1 −1 −1 1 1 1 1 −1 −1 −1 −1 1 −1 1 −1 −1 1 −1 1 1 −1 1 −1 −1 1 −1 1 1 1 1 1 |
| | −1 −1 −1 −1 1 −1 −1 −1 1 1 1 1 −1 −1 1 −1 −1 1 −1 1 1 1 −1 1 1 −1 1 −1 −1 1 1 |
| | 1 −1 1 1 1 −1 −1 −1 −1 1 −1 −1 −1 1 1 −1 1 1 1 −1 1 1 −1 1 −1 −1 −1 1 −1 −1 1 |
| | 1 1 −1 1 1 1 −1 1 1 1 −1 1 1 1 −1 1 −1 1 1 1 −1 1 1 1 −1 1 1 1 −1 1 1 1 1 1 −1 −1 |
| | −1 −1 1 −1 −1 −1 1 1 1 1 −1 1 −1 1 1 −1 1 −1 −1 −1 1 −1 −1 1 −1 1 1 1 1 1 −1 |
| | −1 −1 −1 1 1 1 1 −1 −1 −1 −1 1 1 −1 1 1 −1 1 −1 −1 1 −1 1 1 −1 1 −1 −1 1 1 1 |
| | −1 1 1 1 −1 −1 −1 −1 1 −1 −1 −1 1 −1 1 −1 −1 −1 1 −1 −1 1 −1 1 1 1 −1 1 1 1 1 |
| | 1 −1 1 1 1 −1 1 1 1 −1 1 1 1 −1 −1 1 −1 −1 −1 1 −1 −1 −1 1 −1 −1 −1 1 −1 −1 −1 |
| | −1 −1 1 1 1 1 −1 1 1 1 −1 −1 −1 −1 1 1 −1 1 1 −1 1 −1 −1 −1 1 −1 −1 1 −1 1 1 |
| | −1 −1 −1 1 1 1 1 −1 −1 −1 −1 1 1 1 1 −1 1 −1 1 1 −1 1 −1 −1 1 −1 1 1 −1 1 −1 |
| | −1 1 1 1 −1 1 1 1 −1 −1 −1 −1 1 −1 −1 −1 1 1 −1 1 1 1 −1 1 1 −1 1 −1 −1 −1 1 |
| | −1 −1 1 1 1 −1 1 1 1 −1 1 1 1 −1 1 1 1 −1 1 −1 1 1 1 −1 1 1 1 −1 1 1 1 −1 1 1 1 1 |
| | 1 −1 −1 −1 −1 1 −1 −1 −1 1 1 1 1 −1 1 −1 1 1 −1 1 −1 −1 −1 1 −1 −1 1 −1 1 1 1 |
| | 1 1 −1 −1 −1 −1 1 1 1 1 −1 −1 −1 −1 1 1 −1 1 1 −1 1 −1 −1 1 −1 1 1 −1 1 −1 −1 |
| | 1 1 1 −1 1 1 1 −1 −1 −1 −1 1 −1 −1 −1 1 −1 1 −1 −1 −1 1 −1 −1 1 −1 1 1 1 −1 1 |
| | 1 1 1 1 −1 1 1 1 −1 1 1 1 −1 1 1 1 −1 −1 1 −1 −1 −1 1 −1 −1 −1 1 −1 −1 −1 1 −1 |
| | −1 −1 −1 −1 1 1 1 1 −1 1 1 1 −1 −1 −1 −1 1 1 −1 1 1 −1 1 −1 −1 −1 1 −1 −1 1 −1 |
| | 1 1 −1 −1 −1 1 1 1 1 −1 −1 −1 −1 1 1 1 1 −1 1 −1 1 1 −1 1 −1 −1 1 −1 1 1 −1 1 |
| | −1 −1 1 1 1 −1 −1 −1 −1 1 1 1 1 −1 −1 −1 −1 1 1 −1 1 1 −1 1 −1 −1 1 −1 1 1 −1 |
| | 1 −1 −1 −1 −1 −1 1 1 1 1 −1 1 1 1 −1 −1 −1 −1 1 −1 1 −1 −1 1 −1 1 1 1 −1 1 1 |
| | −1 1 −1 −1 1 1 1 −1 1 1 1 −1 1 1 1 −1 1 1 1 −1 1 −1 1 1 1 −1 1 1 1 −1 1 1 1 −1 1 |
| | 1 −1 −1 −1 1 −1 −1 −1 1 1 1 1 −1 1 1 1 −1 −1 1 −1 −1 −1 1 −1 −1 1 −1 1 1 1 −1 |
| | 1 1 1 1 1 −1 −1 −1 −1 1 1 1 1 −1 −1 −1 −1 1 −1 1 −1 −1 1 −1 1 1 −1 1 −1 −1 1 |
| | −1 1 1 −1 −1 −1 1 1 1 1 −1 1 1 1 −1 −1 −1 −1 1 1 −1 1 1 −1 1 −1 −1 −1 1 −1 −1 |
| | 1 −1 1 1 −1 −1 −1 1 −1 −1 −1 1 −1 −1 −1 1 −1 −1 −1 1 1 −1 1 1 1 −1 1 1 1 −1 1 |
| | 1 1 −1 1 1 1 1 1 −1 1 1 1 −1 −1 −1 −1 1 −1 −1 −1 1 −1 1 −1 −1 −1 1 −1 −1 1 −1 |
| | 1 1 1 −1 1 1 −1 −1 −1 1 1 1 1 −1 −1 −1 −1 1 1 1 1 −1 −1 1 −1 −1 1 −1 1 1 −1 1 |
| | −1 −1 1 −1 1 1 1 1 1 −1 −1 −1 −1 1 −1 −1 −1 1 1 1 1 −1 1 −1 1 1 −1 1 −1 −1 −1 |
| | 1 −1 −1 1 −1 1 1 −1 −1 −1 1 −1 −1 −1 1 −1 −1 −1 1 −1 −1 −1 1 −1 1 −1 −1 −1 1 |
| | −1 −1 −1 1 −1 −1 −1 1 −1 −1 1 1 1 −1 1 1 1 −1 −1 −1 −1 1 −1 −1 −1 1 1 −1 1 1 1 |
| | −1 1 1 −1 1 −1 −1 −1 1 −1 −1 −1 −1 −1 1 1 1 1 −1 −1 −1 −1 1 1 1 1 −1 1 −1 1 1 |
| | −1 1 −1 −1 1 −1 1 1 −1 1 −1 −1 1 1 1 −1 −1 −1 −1 1 −1 −1 −1 1 1 1 1 −1 −1 1 −1 |
| | −1 1 −1 1 1 1 −1 1 1 −1 1 −1 −1 1 1 1 −1 1 1 1 −1 1 1 1 −1 1 1 1 −1 −1 1 −1 −1 |
| | −1 1 −1 −1 −1 1 −1 −1 −1 1 −1 −1 −1 −1 −1 1 −1 −1 −1 1 1 1 1 −1 1 1 1 −1 1 −1 |
| | 1 1 1 −1 1 1 −1 1 −1 −1 −1 1 −1 −1 1 1 1 −1 −1 −1 −1 1 −1 −1 −1 1 1 1 1 −1 1 |
| | −1 1 1 −1 1 −1 −1 −1 1 −1 −1 1 −1 1 1 −1 −1 −1 1 1 1 1 −1 −1 −1 −1 1 1 1 1 −1 |
| | −1 1 −1 −1 1 −1 1 1 −1 1 −1 −1 1 −1 1 1 1 1 1 −1 1 1 1 −1 −1 −1 −1 1 −1 −1 −1 |
| | 1 1 −1 1 1 1 −1 1 1 −1 1 −1 −1 −1 1 −1 −1 −1 −1 −1 1 −1 −1 −1 1 −1 −1 −1 1 −1 |
| | −1 −1 1 −1 1 −1 −1 −1 1 −1 −1 −1 1 −1 −1 −1 1 −1 −1 1 1 1 −1 −1 −1 −1 1 −1 |
| | −1 −1 1 1 1 1 −1 −1 1 −1 −1 1 −1 1 1 1 −1 1 1 −1 1 −1 −1 −1 −1 −1 1 1 1 1 −1 |
| | −1 −1 −1 1 1 1 1 −1 1 −1 1 1 −1 1 −1 −1 1 −1 1 1 −1 1 −1 −1 −1 −1 −1 1 −1 −1 |
| | −1 1 1 1 1 −1 1 1 1 −1 1 −1 1 1 1 −1 1 1 −1 1 −1 −1 −1 1 −1 −1 1 1 1 −1 1 1 1 −1 |
| | 1 1 1 −1 1 1 1 −1 −1 1 −1 −1 −1 1 −1 −1 −1 1 −1 −1 −1 1 −1 −1 1 1 1 −1 −1 −1 |
| | −1 1 −1 −1 −1 1 1 1 1 −1 1 −1 1 1 −1 1 −1 −1 −1 1 −1 −1 1 −1 1 1 −1 −1 −1 1 1 |
| | 1 1 −1 −1 −1 −1 1 1 1 1 −1 −1 1 −1 −1 1 −1 1 1 −1 1 −1 −1 1 −1 1 1 1 1 1 −1 1 1 |
| | 1 −1 −1 −1 −1 1 −1 −1 −1 1 1 −1 1 1 1 −1 1 1 −1 1 −1 −1 −1 1 −1 −1 −1 −1 −1 1 |
| | −1 −1 −1 1 −1 −1 −1 1 −1 −1 −1 1 −1 1 −1 −1 −1 1 −1 −1 −1 1 −1 −1 −1 1 −1 −1 |
| | 1 1 1 −1 −1 −1 −1 1 −1 −1 −1 1 1 1 1 −1 −1 1 −1 −1 1 −1 1 1 1 −1 1 1 −1 1 −1 |
| | −1 −1 −1 −1 1 1 1 1 −1 −1 −1 −1 1 1 1 1 −1 1 −1 1 1 −1 1 −1 −1 1 −1 1 1 −1 1 |
| | −1 −1 −1 −1 −1 1 −1 −1 −1 1 1 1 1 −1 1 1 1 −1 1 −1 1 1 1 −1 1 1 −1 1 −1 −1 −1 |
| | 1 −1 −1 1 1 1 −1 1 1 1 −1 1 1 −1 1 1 1 −1 −1 1 −1 −1 −1 1 −1 −1 −1 1 −1 −1 |
| | −1 1 −1 −1 |
| 11 | 1 1 1 1 1 −1 1 −1 1 1 −1 −1 1 −1 −1 1 1 1 1 1 1 −1 1 −1 1 1 −1 −1 1 −1 −1 1 1 −1 |
| | 1 −1 1 1 1 1 1 −1 −1 1 1 1 −1 −1 1 −1 1 −1 1 1 1 1 1 −1 −1 1 1 1 −1 −1 1 1 1 1 1 |
| | −1 1 −1 1 1 −1 −1 1 −1 −1 1 −1 −1 −1 −1 −1 1 −1 1 −1 −1 1 1 −1 1 1 −1 1 −1 1 |
| | −1 1 1 1 1 1 −1 −1 1 1 1 −1 −1 −1 1 −1 1 −1 −1 −1 −1 −1 1 1 −1 −1 −1 1 1 1 1 1 |
| | 1 1 −1 1 −1 1 1 −1 −1 1 −1 −1 1 1 1 1 1 1 −1 1 −1 1 1 −1 −1 1 −1 −1 1 1 −1 1 −1 |
| | 1 1 1 1 1 −1 −1 1 1 1 −1 −1 1 −1 1 −1 1 1 1 1 1 −1 −1 1 1 1 −1 −1 1 1 1 1 1 −1 1 |
| | −1 1 1 −1 −1 1 −1 −1 1 −1 −1 −1 −1 −1 1 −1 1 −1 −1 1 1 −1 1 1 −1 1 −1 1 −1 1 1 |
| | 1 1 1 −1 −1 1 1 1 −1 −1 −1 1 −1 1 −1 −1 −1 −1 −1 1 1 −1 −1 −1 1 1 1 1 −1 −1 1 |
| | −1 −1 1 1 1 1 1 1 −1 1 −1 1 1 −1 −1 1 −1 −1 1 1 1 1 1 1 −1 1 −1 −1 1 1 −1 −1 −1 |
| | 1 1 −1 1 −1 1 −1 −1 −1 −1 −1 1 1 −1 −1 −1 1 1 −1 1 −1 1 −1 −1 −1 −1 1 1 −1 −1 |
| | 1 −1 −1 1 1 1 1 1 1 −1 1 −1 −1 −1 1 1 −1 1 1 −1 −1 −1 −1 −1 −1 1 −1 1 −1 1 1 |
| | −1 −1 −1 1 1 −1 1 −1 1 −1 −1 −1 −1 1 −1 −1 1 1 1 −1 −1 1 −1 1 −1 1 1 1 1 1 1 |
| | −1 −1 1 −1 −1 1 1 1 1 1 1 −1 1 −1 1 1 −1 −1 1 −1 −1 1 1 1 1 1 1 −1 1 −1 −1 1 1 |
| | −1 −1 −1 1 1 −1 1 −1 1 −1 −1 −1 −1 −1 1 1 −1 −1 −1 1 1 −1 1 −1 1 −1 −1 −1 −1 |
| | 1 1 −1 −1 1 −1 −1 1 1 1 1 1 1 −1 1 −1 −1 −1 1 1 −1 1 1 −1 −1 −1 −1 −1 −1 1 −1 |
| | 1 −1 1 1 −1 −1 −1 1 1 −1 1 −1 1 −1 −1 −1 −1 1 −1 −1 1 1 1 −1 −1 1 −1 1 −1 1 1 |
| | 1 1 1 1 1 1 −1 1 −1 1 1 1 −1 −1 −1 1 1 −1 −1 −1 −1 −1 1 −1 1 −1 −1 −1 1 1 1 −1 |
| | −1 1 1 −1 1 −1 −1 −1 −1 −1 1 −1 −1 1 −1 −1 1 1 −1 1 −1 1 1 1 1 1 −1 1 1 −1 1 1 |
| | −1 −1 1 1 1 1 −1 1 −1 1 1 1 −1 −1 −1 1 1 −1 1 1 1 1 −1 1 −1 1 1 1 −1 −1 −1 1 1 |
| | −1 1 −1 1 −1 −1 −1 −1 −1 1 −1 −1 1 −1 −1 1 1 1 −1 1 −1 −1 −1 −1 −1 1 −1 −1 1 |
| | −1 −1 1 1 1 1 1 1 −1 1 −1 1 1 1 −1 −1 −1 1 1 −1 −1 −1 −1 −1 1 −1 1 −1 −1 −1 1 |
| | 1 1 −1 −1 1 1 −1 1 −1 −1 −1 −1 −1 1 −1 −1 1 −1 −1 1 1 −1 1 −1 1 1 1 1 1 −1 1 1 |
| | −1 1 1 −1 −1 1 1 1 1 −1 1 −1 1 1 1 −1 −1 −1 1 1 −1 1 1 1 1 −1 1 −1 1 1 1 −1 −1 |
| | −1 1 1 −1 1 −1 1 −1 −1 −1 −1 −1 1 −1 −1 1 −1 −1 1 1 1 −1 1 −1 −1 −1 −1 −1 1 |
| | −1 −1 1 −1 −1 1 1 1 1 −1 −1 −1 1 1 −1 1 1 1 1 −1 1 −1 1 −1 −1 1 1 1 −1 −1 1 −1 |
| | −1 −1 −1 1 −1 1 −1 −1 1 1 −1 1 1 −1 −1 −1 1 −1 1 1 1 1 1 1 −1 −1 1 −1 −1 1 1 1 |
| | −1 1 −1 −1 −1 −1 −1 1 1 −1 −1 −1 1 1 −1 1 1 1 1 −1 1 −1 1 1 1 −1 −1 −1 1 1 −1 |
| | 1 1 1 1 −1 1 −1 1 −1 1 1 −1 1 1 −1 −1 −1 1 −1 1 1 1 1 1 −1 1 1 −1 1 1 −1 −1 −1 1 |
| | −1 1 1 1 1 1 1 1 −1 −1 −1 1 1 −1 1 1 1 1 −1 1 −1 1 −1 −1 1 1 1 −1 −1 1 −1 −1 −1 |
| | −1 1 −1 1 −1 −1 1 1 −1 1 1 −1 −1 −1 1 −1 1 1 1 1 1 1 −1 −1 1 −1 −1 1 1 1 −1 1 |
| | −1 −1 −1 −1 −1 1 1 −1 −1 −1 1 1 −1 1 1 1 1 −1 1 −1 1 1 1 −1 −1 −1 1 1 −1 1 1 1 |
| | 1 −1 1 −1 1 −1 1 1 −1 1 1 −1 −1 −1 1 −1 1 1 1 1 1 −1 1 1 −1 1 1 −1 −1 −1 1 −1 1 |
| | 1 1 1 1 1 1 1 1 1 −1 1 −1 1 1 −1 −1 1 −1 −1 1 1 1 1 1 1 −1 1 −1 1 1 −1 −1 1 −1 |
| | −1 1 1 −1 1 −1 1 1 1 1 1 −1 −1 1 1 1 −1 −1 1 −1 1 −1 1 1 1 1 1 −1 −1 1 1 1 −1 −1 |
| | −1 −1 −1 −1 −1 1 −1 1 −1 −1 1 1 −1 1 1 −1 1 1 1 1 1 −1 1 −1 1 1 −1 −1 1 −1 −1 |
| | 1 −1 1 −1 1 −1 −1 −1 −1 −1 1 1 −1 −1 −1 1 1 1 −1 1 −1 1 1 1 1 1 −1 −1 1 1 1 −1 |
| | −1 −1 −1 −1 −1 −1 1 −1 1 −1 −1 1 1 −1 1 1 −1 −1 −1 −1 −1 −1 1 −1 1 −1 −1 1 1 |
| | −1 1 1 −1 −1 1 −1 1 −1 −1 −1 −1 −1 1 1 −1 −1 −1 1 1 −1 1 −1 1 −1 −1 −1 −1 −1 |
| | 1 1 −1 −1 −1 1 1 1 1 1 1 1 −1 1 −1 1 1 −1 −1 1 −1 −1 1 −1 −1 −1 −1 −1 1 −1 1 |
| | −1 −1 1 1 −1 1 1 −1 1 −1 1 −1 1 1 1 1 1 −1 −1 1 1 1 −1 −1 −1 1 −1 1 −1 −1 −1 |
| | −1 −1 1 1 −1 −1 −1 1 1 1 1 −1 −1 1 −1 −1 1 1 1 1 1 1 −1 1 −1 1 1 −1 −1 1 −1 −1 |
| | 1 1 1 1 1 1 −1 1 −1 −1 1 1 −1 −1 −1 1 1 −1 1 −1 1 −1 −1 −1 −1 −1 1 1 −1 −1 −1 |
| | 1 1 −1 1 −1 1 −1 −1 −1 −1 −1 −1 1 1 −1 1 1 −1 −1 −1 −1 −1 −1 1 −1 1 1 1 −1 −1 |
| | 1 −1 −1 1 1 1 1 1 1 −1 1 −1 1 −1 −1 1 1 1 −1 −1 1 −1 1 −1 1 1 1 1 −1 1 1 −1 −1 |
| | −1 1 1 −1 1 −1 1 −1 −1 −1 −1 −1 −1 1 1 −1 1 1 −1 −1 −1 −1 −1 −1 1 −1 1 −1 −1 |
| | 1 1 −1 1 1 −1 −1 −1 −1 −1 −1 1 −1 1 1 −1 −1 1 1 1 −1 −1 1 −1 1 −1 1 1 1 1 1 −1 |
| | −1 1 1 1 −1 −1 1 −1 1 −1 1 1 1 1 1 1 −1 −1 1 −1 −1 1 1 1 1 1 1 −1 1 −1 −1 −1 1 1 |
| | −1 1 1 −1 −1 −1 −1 −1 −1 1 −1 1 −1 1 1 −1 −1 −1 1 1 −1 1 −1 1 −1 −1 −1 −1 1 |
| | −1 −1 1 1 1 −1 −1 1 −1 1 −1 1 1 1 1 1 1 1 1 −1 1 −1 1 1 1 −1 −1 −1 1 1 −1 −1 −1 |
| | −1 −1 1 −1 1 −1 −1 −1 1 1 1 −1 −1 1 1 −1 1 −1 −1 −1 −1 −1 1 −1 −1 1 −1 −1 1 1 |
| | −1 1 −1 1 1 1 1 1 −1 1 1 −1 1 1 −1 −1 −1 −1 −1 −1 1 −1 1 −1 −1 −1 1 1 1 −1 −1 |
| | 1 −1 −1 −1 −1 1 −1 1 −1 −1 −1 1 1 1 −1 −1 1 −1 1 −1 1 1 1 1 1 −1 1 1 −1 1 1 −1 |
| | −1 −1 1 −1 1 1 1 1 1 −1 1 1 −1 1 1 −1 −1 −1 −1 −1 −1 1 −1 1 −1 −1 −1 1 1 1 −1 |
| | −1 1 1 1 1 1 −1 1 −1 1 1 1 −1 −1 −1 1 1 −1 −1 1 −1 1 1 1 1 1 −1 1 1 −1 1 1 −1 −1 |
| | 1 −1 1 −1 −1 −1 −1 −1 1 −1 −1 1 −1 −1 1 1 1 1 1 1 −1 1 −1 1 1 1 −1 −1 −1 1 1 |
| | −1 1 1 1 1 −1 1 −1 1 1 1 −1 −1 −1 1 1 −1 1 −1 1 −1 −1 −1 −1 −1 1 −1 −1 1 −1 −1 |
| | 1 1 1 −1 1 −1 −1 −1 −1 −1 1 −1 −1 1 −1 −1 1 1 1 1 −1 −1 −1 1 1 −1 1 1 1 1 −1 1 |
| | −1 1 −1 −1 1 1 1 −1 −1 1 −1 −1 −1 −1 1 −1 1 −1 −1 1 1 −1 1 1 −1 −1 −1 1 −1 1 1 |
| | 1 1 1 1 −1 −1 1 −1 −1 1 1 1 −1 1 −1 −1 −1 −1 −1 −1 −1 1 1 1 −1 −1 1 −1 −1 −1 |
| | −1 1 −1 1 −1 −1 −1 1 1 1 −1 −1 1 −1 −1 −1 −1 1 −1 1 −1 1 −1 −1 1 −1 −1 1 1 1 |
| | −1 1 −1 −1 −1 −1 −1 1 −1 −1 1 −1 −1 1 1 1 −1 1 −1 −1 −1 −1 −1 −1 −1 1 1 1 −1 |
| | −1 1 −1 −1 −1 −1 1 −1 1 −1 1 1 −1 −1 −1 1 1 −1 1 1 1 1 −1 1 −1 1 1 −1 −1 1 −1 |
| | −1 1 1 1 −1 1 −1 −1 −1 −1 −1 −1 1 1 −1 1 1 −1 −1 −1 1 −1 1 1 1 1 1 1 1 −1 −1 |
| | −1 1 1 −1 1 1 1 1 −1 1 −1 1 1 1 −1 −1 −1 1 1 −1 1 1 1 1 −1 1 −1 1 −1 1 1 −1 1 1 |
| | −1 −1 −1 1 −1 1 1 1 1 1 −1 1 1 −1 1 1 −1 −1 −1 1 −1 1 1 1 1 1 1 1 1 1 1 −1 1 −1 |
| | 1 1 −1 −1 1 −1 −1 1 1 1 1 1 1 −1 1 −1 1 1 −1 −1 1 −1 −1 1 1 −1 1 −1 1 1 1 1 1 −1 |
| | −1 1 1 1 −1 −1 1 −1 1 −1 1 1 1 1 1 −1 −1 1 1 1 −1 −1 1 1 1 1 1 −1 1 −1 1 1 −1 −1 |
| | 1 −1 −1 1 −1 −1 −1 −1 −1 1 −1 1 −1 −1 1 1 −1 1 1 −1 1 −1 1 −1 1 1 1 1 1 −1 −1 |
| | 1 1 1 −1 −1 −1 1 −1 1 −1 −1 −1 −1 −1 1 1 −1 −1 −1 1 1 −1 −1 −1 −1 −1 1 −1 1 |
| | −1 −1 1 1 −1 1 1 −1 −1 −1 −1 −1 −1 1 −1 1 −1 −1 1 1 −1 1 1 −1 −1 1 −1 1 −1 −1 |
| | −1 −1 −1 1 1 −1 −1 −1 1 1 −1 1 −1 1 −1 −1 −1 −1 −1 1 1 −1 −1 −1 1 1 −1 −1 −1 |
| | −1 −1 1 −1 1 −1 −1 1 1 −1 1 1 −1 1 1 1 1 1 −1 1 −1 1 1 −1 −1 1 −1 −1 1 −1 1 −1 |
| | 1 −1 −1 −1 −1 −1 1 1 −1 −1 −1 1 1 1 −1 1 −1 1 1 1 1 1 −1 −1 1 1 1 −1 −1 1 1 −1 |
| | −1 1 −1 −1 1 1 1 1 1 1 −1 1 −1 1 1 −1 −1 1 −1 −1 1 1 1 1 1 1 −1 1 −1 −1 1 1 −1 |
| | −1 −1 1 1 −1 1 −1 1 −1 −1 −1 −1 −1 1 1 −1 −1 −1 1 1 −1 1 −1 1 −1 −1 −1 −1 1 1 |
| | −1 −1 1 −1 −1 1 1 1 1 1 1 −1 1 −1 −1 −1 1 1 −1 1 1 −1 −1 −1 −1 −1 −1 1 −1 1 −1 |
| | 1 1 −1 −1 −1 1 1 −1 1 −1 1 −1 −1 −1 −1 1 −1 −1 1 1 1 −1 −1 1 −1 1 −1 1 1 1 1 |
| | −1 −1 1 1 −1 1 1 −1 −1 −1 −1 −1 −1 1 −1 1 −1 −1 1 1 −1 1 1 −1 −1 −1 −1 −1 −1 |
| | 1 −1 1 1 −1 −1 1 1 1 −1 −1 1 −1 1 −1 1 1 1 1 1 −1 −1 1 1 1 −1 −1 1 −1 1 −1 1 1 1 |
| | 1 −1 −1 1 1 −1 1 1 −1 −1 −1 −1 −1 −1 1 −1 1 1 1 −1 −1 1 −1 −1 1 1 1 1 1 1 −1 1 |
| | −1 1 −1 −1 1 1 1 −1 −1 1 −1 1 −1 1 1 1 1 −1 1 1 −1 −1 −1 1 1 −1 1 −1 1 −1 −1 |
| | −1 −1 1 1 1 1 −1 1 −1 1 1 1 −1 −1 −1 1 1 −1 −1 −1 −1 −1 1 −1 1 −1 −1 −1 1 1 1 |
| | −1 −1 1 1 −1 1 −1 −1 −1 −1 −1 1 −1 −1 1 −1 −1 1 1 −1 1 −1 1 1 1 1 −1 1 1 −1 |
| | 1 1 −1 −1 1 1 1 1 −1 1 −1 1 1 1 −1 −1 −1 1 1 −1 1 1 1 1 −1 1 −1 1 1 1 −1 −1 −1 1 |
| | 1 −1 1 −1 1 −1 −1 −1 −1 −1 1 −1 −1 1 −1 −1 1 1 1 −1 1 −1 −1 −1 −1 −1 1 −1 −1 |
| | 1 −1 −1 1 1 −1 −1 −1 −1 1 −1 1 −1 −1 −1 1 1 1 −1 −1 1 1 1 1 1 −1 1 −1 1 1 1 −1 |
| | −1 −1 1 1 −1 −1 1 −1 1 1 1 1 1 −1 1 1 −1 1 1 −1 −1 1 −1 1 −1 −1 −1 −1 −1 1 −1 |
| | −1 1 −1 −1 1 1 −1 −1 −1 −1 1 −1 1 −1 −1 −1 1 1 1 −1 −1 1 −1 −1 −1 −1 1 −1 1 |
| | −1 −1 −1 1 1 1 −1 −1 1 −1 1 −1 1 1 1 1 1 −1 1 1 −1 1 1 −1 −1 −1 1 −1 1 1 1 1 1 |
| | −1 1 1 −1 1 1 −1 −1 1 1 −1 −1 −1 1 1 −1 1 1 1 1 −1 1 −1 1 −1 −1 1 1 1 −1 −1 1 |
| | −1 −1 −1 −1 1 −1 1 −1 −1 1 1 −1 1 1 −1 −1 −1 1 −1 1 1 1 1 1 1 −1 −1 1 −1 −1 1 |
| | 1 1 −1 1 −1 −1 −1 −1 −1 1 1 −1 −1 −1 1 1 −1 1 1 1 1 −1 1 −1 1 1 1 −1 −1 −1 1 1 |
| | −1 1 1 1 1 −1 1 −1 1 −1 1 1 −1 1 1 −1 −1 −1 1 −1 1 1 1 1 1 −1 1 1 −1 1 1 −1 −1 |
| | −1 1 −1 1 1 1 1 1 −1 −1 1 1 1 −1 −1 1 −1 −1 −1 −1 1 −1 1 −1 1 1 −1 −1 −1 1 1 |
| | −1 1 1 1 1 −1 1 −1 1 1 −1 −1 1 −1 −1 1 1 1 −1 1 −1 −1 −1 −1 −1 −1 1 1 −1 1 1 |
| | −1 −1 −1 1 −1 1 1 1 1 1 −1 −1 1 1 1 −1 −1 1 −1 −1 −1 −1 1 −1 1 −1 −1 −1 1 1 1 |
| | −1 −1 1 −1 −1 −1 −1 1 −1 1 −1 1 −1 −1 1 −1 −1 1 1 1 −1 1 −1 −1 −1 −1 −1 1 −1 |
| | −1 1 −1 −1 1 1 1 −1 1 −1 −1 −1 −1 −1 1 1 1 1 1 −1 1 −1 1 1 −1 −1 1 −1 −1 1 1 1 |
| | 1 1 1 −1 1 −1 1 1 −1 −1 1 −1 −1 1 1 −1 1 −1 1 1 1 1 1 −1 −1 1 1 1 −1 −1 1 −1 1 |
| | −1 1 1 1 1 1 −1 −1 1 1 1 −1 −1 −1 −1 −1 −1 −1 1 −1 1 −1 −1 1 1 −1 1 1 −1 1 1 1 |
| | 1 1 −1 1 −1 1 1 −1 −1 1 −1 −1 1 −1 1 −1 1 −1 −1 −1 −1 −1 1 1 −1 −1 −1 1 1 1 −1 |
| | 1 −1 1 1 1 1 1 −1 −1 1 1 1 −1 −1 1 1 1 1 1 −1 1 −1 1 1 −1 −1 1 −1 −1 1 1 1 1 1 |
| | −1 1 −1 1 1 −1 −1 1 −1 −1 1 1 −1 1 −1 1 1 1 1 1 −1 −1 1 1 1 −1 −1 1 −1 1 −1 1 1 |
| | 1 1 1 −1 −1 1 1 1 −1 −1 −1 −1 −1 −1 −1 1 −1 1 −1 −1 1 1 −1 1 1 −1 1 1 1 1 1 −1 |
| | 1 −1 1 1 −1 −1 1 −1 −1 1 −1 1 −1 1 −1 −1 −1 −1 −1 1 1 −1 −1 −1 1 1 1 −1 1 −1 1 |
| | 1 1 1 1 −1 −1 1 1 1 −1 −1 1 1 −1 −1 1 −1 −1 1 1 1 1 1 1 −1 1 −1 1 1 −1 −1 1 −1 |
| | −1 1 1 1 1 1 1 −1 1 −1 −1 1 1 −1 −1 −1 1 1 −1 1 −1 1 −1 −1 −1 −1 −1 1 1 −1 −1 |
| | −1 1 1 −1 1 −1 1 −1 −1 −1 −1 −1 −1 1 1 −1 1 1 −1 −1 −1 −1 −1 −1 1 −1 1 1 1 −1 |
| | −1 1 −1 −1 1 1 1 1 1 1 −1 1 −1 1 −1 −1 1 1 1 −1 −1 1 −1 1 −1 1 1 1 1 −1 1 1 −1 |
| | −1 −1 1 1 −1 1 −1 1 −1 −1 −1 −1 1 1 −1 −1 1 −1 −1 1 1 1 1 1 1 −1 1 −1 1 1 −1 |
| | −1 1 −1 −1 1 1 1 1 1 −1 1 −1 −1 1 1 −1 −1 −1 1 1 −1 1 −1 1 −1 −1 −1 −1 −1 1 |
| | 1 −1 −1 −1 1 1 −1 1 −1 1 −1 −1 −1 −1 −1 −1 1 1 −1 1 1 −1 −1 −1 −1 −1 −1 1 −1 |
| | 1 1 1 −1 −1 1 −1 −1 1 1 1 1 1 1 −1 1 −1 1 −1 −1 1 1 1 −1 −1 1 −1 1 −1 1 1 1 1 −1 |
| | 1 1 −1 −1 −1 1 1 −1 1 −1 1 −1 −1 −1 −1 1 1 1 1 −1 1 −1 1 1 1 −1 −1 −1 1 1 −1 |
| | −1 −1 −1 −1 1 −1 1 −1 −1 −1 1 1 1 −1 −1 1 1 −1 1 −1 −1 −1 −1 −1 1 −1 −1 1 −1 |
| | −1 1 1 −1 1 −1 1 1 1 1 1 −1 1 1 −1 1 1 −1 −1 −1 −1 −1 −1 1 −1 1 −1 −1 −1 1 1 1 |
| | −1 −1 1 −1 −1 −1 −1 1 −1 1 −1 −1 −1 1 1 1 −1 −1 1 −1 1 −1 1 1 1 1 1 −1 1 1 −1 |
| | 1 1 −1 −1 −1 1 −1 1 1 1 1 1 −1 1 1 −1 1 1 −1 −1 1 1 1 1 −1 1 −1 1 1 1 −1 −1 −1 1 |
| | 1 −1 −1 −1 −1 −1 1 −1 1 −1 −1 −1 1 1 1 −1 −1 1 1 −1 1 −1 −1 −1 −1 −1 1 −1 −1 |
| | 1 −1 −1 1 1 −1 1 −1 1 1 1 1 1 −1 1 1 −1 1 1 −1 −1 −1 −1 −1 −1 1 −1 1 −1 −1 −1 |
| | 1 1 1 −1 −1 1 −1 −1 −1 −1 1 −1 1 −1 −1 −1 1 1 1 −1 −1 1 −1 1 −1 1 1 1 1 1 −1 1 |
| | 1 −1 1 1 −1 −1 −1 1 −1 1 1 1 1 1 −1 1 1 −1 1 1 −1 −1 1 1 −1 −1 −1 1 1 −1 1 1 1 1 |
| | −1 1 −1 1 −1 −1 1 1 1 −1 −1 1 −1 −1 −1 −1 1 −1 1 −1 −1 1 1 −1 1 1 −1 −1 −1 1 |
| | −1 1 1 1 1 1 1 −1 −1 1 −1 −1 1 1 1 −1 1 −1 −1 −1 −1 −1 −1 −1 1 1 1 −1 −1 1 −1 |
| | −1 −1 −1 1 −1 1 −1 −1 −1 1 1 1 −1 −1 1 −1 −1 −1 −1 1 −1 1 −1 1 −1 −1 1 −1 −1 |
| | 1 1 1 −1 1 −1 −1 −1 −1 −1 1 −1 −1 1 −1 −1 1 1 1 −1 1 −1 −1 −1 −1 −1 1 1 −1 −1 |
| | −1 1 1 −1 1 1 1 1 −1 1 −1 1 −1 −1 1 1 1 −1 −1 1 −1 −1 −1 −1 1 −1 1 −1 −1 1 1 |
| | −1 1 1 −1 −1 −1 1 −1 1 1 1 1 1 1 −1 −1 1 −1 −1 1 1 1 −1 1 −1 −1 −1 −1 −1 −1 −1 |
| | 1 1 1 −1 −1 1 −1 −1 −1 −1 1 −1 1 −1 −1 −1 1 1 1 −1 −1 1 −1 −1 −1 −1 1 −1 1 −1 |
| | 1 −1 −1 1 −1 −1 1 1 1 −1 1 −1 −1 −1 −1 −1 1 −1 −1 1 −1 −1 1 1 1 −1 1 −1 −1 −1 |
| | −1 −1 −1 −1 −1 −1 −1 1 −1 1 −1 −1 1 1 −1 1 1 −1 −1 −1 −1 −1 −1 1 −1 1 −1 −1 |
| | 1 1 −1 1 1 −1 −1 1 −1 1 −1 −1 −1 −1 −1 1 1 −1 −1 −1 1 1 −1 1 −1 1 −1 −1 −1 −1 |
| | −1 1 1 −1 −1 −1 1 1 −1 −1 −1 −1 −1 1 −1 1 −1 −1 1 1 −1 1 1 −1 1 1 1 1 1 −1 1 |
| | −1 1 1 −1 −1 1 −1 −1 1 −1 1 −1 1 −1 −1 −1 −1 −1 1 1 −1 −1 −1 1 1 1 −1 1 −1 1 1 |
| | 1 1 1 −1 −1 1 1 1 −1 −1 −1 −1 −1 −1 −1 1 −1 1 −1 −1 1 1 −1 1 1 −1 −1 −1 −1 −1 |
| | −1 1 −1 1 −1 −1 1 1 −1 1 1 −1 −1 1 −1 1 −1 −1 −1 −1 −1 1 1 −1 −1 −1 1 1 −1 1 |
| | −1 1 −1 −1 −1 −1 −1 1 1 −1 −1 −1 1 1 −1 −1 −1 −1 −1 1 −1 1 −1 −1 1 1 −1 1 1 |
| | −1 1 1 1 1 1 −1 1 −1 1 1 −1 −1 1 −1 −1 1 −1 1 −1 1 −1 −1 −1 −1 −1 1 1 −1 −1 −1 |
| | 1 1 1 −1 1 −1 1 1 1 1 1 −1 −1 1 1 1 −1 −1 −1 −1 1 1 −1 1 1 −1 −1 −1 −1 −1 −1 1 |
| | −1 1 −1 −1 1 1 −1 1 1 −1 −1 −1 −1 −1 −1 1 −1 1 1 −1 −1 1 1 1 −1 −1 1 −1 1 −1 1 |
| | 1 1 1 1 −1 −1 1 1 1 −1 −1 1 −1 1 −1 1 1 1 1 −1 −1 1 1 −1 1 1 −1 −1 −1 −1 −1 −1 |
| | 1 −1 1 1 1 −1 −1 1 −1 −1 1 1 1 1 1 1 −1 1 −1 1 −1 −1 1 1 1 −1 −1 1 −1 1 −1 1 1 1 |
| | 1 −1 1 1 −1 −1 −1 1 1 −1 1 −1 1 −1 −1 −1 −1 −1 −1 1 1 −1 1 1 −1 −1 −1 −1 −1 |
| | −1 1 −1 1 −1 −1 1 1 −1 1 1 −1 −1 −1 −1 −1 −1 1 −1 1 1 −1 −1 1 1 1 −1 −1 1 −1 1 |
| | −1 1 1 1 1 1 −1 −1 1 1 1 −1 −1 1 −1 1 −1 1 1 1 1 −1 −1 1 1 −1 1 1 −1 −1 −1 −1 |
| | −1 −1 1 −1 1 1 1 −1 −1 1 −1 −1 1 1 1 1 1 1 −1 1 −1 1 −1 −1 1 1 1 −1 −1 1 −1 1 |
| | −1 1 1 1 −1 1 1 −1 −1 −1 1 1 −1 1 −1 1 −1 −1 −1 −1 −1 −1 −1 −1 1 −1 1 −1 −1 |
| | −1 1 1 1 −1 −1 1 1 1 1 1 −1 1 −1 1 1 1 −1 −1 −1 1 1 −1 −1 1 −1 1 1 1 1 1 −1 1 1 |
| | −1 1 1 −1 −1 1 −1 1 −1 −1 −1 −1 −1 1 −1 −1 1 −1 −1 1 1 −1 −1 −1 −1 1 −1 1 −1 |
| | −1 −1 1 1 1 −1 −1 1 −1 −1 −1 −1 1 −1 1 −1 −1 −1 1 1 1 −1 −1 1 −1 1 −1 1 1 1 1 |
| | 1 −1 1 1 −1 1 1 −1 −1 −1 1 −1 1 1 1 1 1 −1 1 1 −1 1 1 −1 −1 −1 −1 −1 −1 1 −1 1 |
| | −1 −1 −1 1 1 1 −1 −1 1 1 1 1 1 −1 1 −1 1 1 1 −1 −1 −1 1 1 −1 −1 1 −1 1 1 1 1 1 |
| | −1 1 1 −1 1 1 −1 −1 1 −1 1 −1 −1 −1 −1 −1 1 −1 −1 1 −1 −1 1 1 −1 −1 −1 −1 1 |
| | −1 1 −1 −1 −1 1 1 1 −1 −1 1 −1 −1 −1 −1 1 −1 1 −1 −1 −1 1 1 1 −1 −1 1 −1 1 −1 |
| | 1 1 1 1 1 −1 1 1 −1 1 1 −1 −1 −1 1 −1 1 1 1 1 1 −1 1 1 −1 1 1 −1 −1 −1 −1 1 1 1 |
| | −1 −1 1 −1 −1 −1 −1 1 −1 1 −1 1 1 −1 −1 −1 1 1 −1 1 1 1 1 −1 1 −1 1 1 −1 −1 1 |
| | −1 −1 1 1 1 −1 1 −1 −1 −1 −1 −1 −1 1 1 −1 1 1 −1 −1 −1 1 −1 1 1 1 1 1 −1 −1 1 |
| | 1 1 −1 −1 1 −1 −1 −1 −1 1 −1 1 −1 −1 −1 1 1 1 −1 −1 1 −1 −1 −1 −1 1 −1 1 −1 1 |
| | −1 −1 1 −1 −1 1 1 1 −1 1 −1 −1 −1 −1 −1 1 −1 −1 1 −1 −1 1 1 1 −1 1 −1 −1 −1 |
| | −1 −1 −1 −1 1 1 1 −1 −1 1 −1 −1 −1 −1 1 −1 1 −1 1 1 −1 −1 −1 1 1 −1 1 1 1 1 −1 |
| | 1 −1 1 1 −1 −1 1 −1 −1 1 1 1 −1 1 −1 −1 −1 −1 −1 −1 1 1 −1 1 1 −1 −1 −1 1 −1 1 |
| | 1 1 1 1 −1 −1 1 1 1 −1 −1 1 −1 −1 −1 −1 1 −1 1 −1 −1 −1 1 1 1 −1 −1 1 −1 −1 −1 |
| | −1 1 −1 1 −1 1 −1 −1 1 −1 −1 1 1 1 −1 1 −1 −1 −1 −1 −1 1 −1 −1 1 −1 −1 1 1 1 |
| | −1 1 −1 −1 −1 −1 −1 −1 −1 −1 −1 −1 1 −1 1 −1 −1 1 1 −1 1 1 −1 −1 −1 −1 −1 −1 |
| | 1 −1 1 −1 −1 1 1 −1 1 1 −1 −1 1 −1 1 −1 −1 −1 −1 −1 1 1 −1 −1 −1 1 1 −1 1 −1 1 |
| | −1 −1 −1 −1 −1 1 1 −1 −1 −1 1 1 1 1 1 1 1 −1 1 −1 1 1 −1 −1 1 −1 −1 1 −1 −1 −1 |
| | −1 −1 1 −1 1 −1 −1 1 1 −1 1 1 −1 1 −1 1 −1 1 1 1 1 1 −1 −1 1 1 1 −1 −1 −1 1 −1 |
| | 1 −1 −1 −1 −1 −1 1 1 −1 −1 −1 1 1 1 1 1 1 1 −1 1 −1 1 1 −1 −1 1 −1 −1 1 1 1 1 1 |
| | 1 −1 1 −1 1 1 −1 −1 1 −1 −1 1 1 −1 1 −1 1 1 1 1 1 −1 −1 1 1 1 −1 −1 1 −1 1 −1 1 |
| | 1 1 1 1 −1 −1 1 1 1 −1 −1 −1 −1 −1 −1 −1 1 −1 1 −1 −1 1 1 −1 1 1 −1 1 1 1 1 1 |
| | −1 1 −1 1 1 −1 −1 1 −1 −1 1 −1 1 −1 1 −1 −1 −1 −1 −1 1 1 −1 −1 −1 1 1 1 −1 1 |
| | −1 1 1 1 1 1 −1 −1 1 1 1 −1 −1 −1 −1 1 1 −1 1 1 −1 −1 −1 −1 −1 −1 1 −1 1 −1 −1 |
| | 1 1 −1 1 1 −1 −1 −1 −1 −1 −1 1 −1 1 1 −1 −1 1 1 1 −1 −1 1 −1 1 −1 1 1 1 1 1 −1 |
| | −1 1 1 1 −1 −1 1 −1 1 −1 1 1 1 1 1 1 −1 −1 1 −1 −1 1 1 1 1 1 1 −1 1 −1 −1 −1 1 1 |
| | −1 1 1 −1 −1 −1 −1 −1 −1 1 −1 1 −1 1 1 −1 −1 −1 1 1 −1 1 −1 1 −1 −1 −1 −1 1 |
| | −1 −1 1 1 1 −1 −1 1 −1 1 −1 1 1 1 1 1 1 −1 −1 1 −1 −1 1 1 1 1 1 1 −1 1 −1 1 1 −1 |
| | −1 1 −1 −1 1 1 1 1 1 1 −1 1 −1 −1 1 1 −1 −1 −1 1 1 −1 1 −1 1 −1 −1 −1 −1 −1 1 |
| | 1 −1 −1 −1 1 1 −1 1 −1 1 −1 −1 −1 −1 −1 −1 1 1 −1 1 1 −1 −1 −1 −1 −1 −1 1 −1 |
| | 1 1 1 −1 −1 1 −1 −1 1 1 1 1 1 1 −1 1 −1 1 −1 −1 1 1 1 −1 −1 1 −1 1 −1 1 1 1 1 −1 |
| | 1 1 −1 −1 −1 1 1 −1 1 −1 1 −1 −1 −1 −1 −1 −1 −1 −1 1 −1 1 −1 −1 −1 1 1 1 −1 |
| | −1 1 1 1 1 1 −1 1 −1 1 1 1 −1 −1 −1 1 1 −1 −1 1 −1 1 1 1 1 1 −1 1 1 −1 1 1 −1 −1 |
| | 1 −1 1 −1 −1 −1 −1 −1 1 −1 −1 1 −1 −1 1 1 1 1 1 1 −1 1 −1 1 1 1 −1 −1 −1 1 1 |
| | −1 1 1 1 1 −1 1 −1 1 1 1 −1 −1 −1 1 1 −1 1 −1 1 −1 −1 −1 −1 −1 1 −1 −1 1 −1 −1 |
| | 1 1 1 −1 1 −1 −1 −1 −1 −1 1 −1 −1 1 −1 −1 1 1 1 1 1 1 −1 1 −1 1 1 1 −1 −1 −1 1 |
| | 1 −1 −1 −1 −1 −1 1 −1 1 −1 −1 −1 1 1 1 −1 −1 1 1 −1 1 −1 −1 −1 −1 −1 1 −1 −1 |
| | 1 −1 −1 1 1 −1 1 −1 1 1 1 1 1 −1 1 1 −1 1 1 −1 −1 −1 −1 −1 −1 1 −1 1 −1 −1 −1 |
| | 1 1 1 −1 −1 1 −1 −1 −1 −1 1 −1 1 −1 −1 −1 1 1 1 −1 −1 1 −1 1 −1 1 1 1 1 1 −1 1 |
| | 1 −1 1 1 −1 −1 −1 1 −1 1 1 1 1 1 −1 1 1 −1 1 1 −1 −1 −1 −1 1 1 1 −1 −1 1 −1 −1 |
| | −1 −1 1 −1 1 −1 1 1 −1 −1 −1 1 1 −1 1 1 1 1 −1 1 −1 1 1 −1 −1 1 −1 −1 1 1 1 −1 |
| | 1 −1 −1 −1 −1 −1 −1 1 1 −1 1 1 −1 −1 −1 1 −1 1 1 1 1 1 1 1 −1 −1 −1 1 1 −1 1 1 |
| | 1 1 −1 1 −1 1 1 1 −1 −1 −1 1 1 −1 1 1 1 1 −1 1 −1 1 −1 1 1 −1 1 1 −1 −1 −1 1 −1 |
| | 1 1 1 1 1 −1 1 1 −1 1 1 −1 −1 −1 1 −1 1 1 1 1 1 1 1 −1 −1 −1 1 1 −1 1 1 1 1 −1 1 |
| | −1 1 −1 −1 1 1 1 −1 −1 1 −1 −1 −1 −1 1 −1 1 −1 −1 1 1 −1 1 1 −1 −1 −1 1 −1 1 1 |
| | 1 1 1 1 −1 −1 1 −1 −1 1 1 1 −1 1 −1 −1 −1 −1 −1 −1 −1 1 1 1 −1 −1 1 −1 −1 −1 |
| | −1 1 −1 1 −1 −1 1 1 1 −1 −1 1 −1 −1 −1 −1 1 −1 1 −1 1 −1 −1 1 −1 −1 1 1 1 |
| | −1 1 −1 −1 −1 −1 −1 1 −1 −1 1 −1 −1 1 1 1 −1 1 −1 −1 −1 −1 −1 1 1 1 1 1 −1 1 |
| | −1 1 1 −1 −1 1 −1 −1 1 1 1 1 1 1 −1 1 −1 1 1 −1 −1 1 −1 −1 1 1 −1 1 −1 1 1 1 1 1 |
| | −1 −1 1 1 1 −1 −1 1 −1 1 −1 1 1 1 1 1 −1 −1 1 1 1 −1 −1 1 1 1 1 1 −1 1 −1 1 1 −1 |
| | −1 1 −1 −1 1 −1 −1 −1 −1 −1 1 −1 1 −1 −1 1 1 −1 1 1 −1 1 −1 1 −1 1 1 1 1 1 −1 |
| | −1 1 1 1 −1 −1 −1 1 −1 1 −1 −1 −1 −1 −1 1 1 −1 −1 −1 1 1 −1 −1 −1 −1 −1 1 −1 |
| | 1 −1 −1 1 1 −1 1 1 −1 −1 −1 −1 −1 −1 1 −1 1 −1 −1 1 1 −1 1 1 −1 −1 1 −1 1 −1 |
| | −1 −1 −1 −1 1 1 −1 −1 −1 1 1 −1 1 −1 1 −1 −1 −1 −1 −1 1 1 −1 −1 −1 1 1 −1 −1 |
| | −1 −1 −1 1 −1 1 −1 −1 1 1 −1 1 1 −1 1 1 1 1 1 −1 1 −1 1 1 −1 −1 1 −1 −1 1 −1 1 |
| | −1 1 −1 −1 −1 −1 −1 1 1 −1 −1 −1 1 1 1 −1 1 −1 1 1 1 1 1 −1 −1 1 1 1 −1 −1 1 1 |
| | −1 −1 1 −1 −1 1 1 1 1 1 1 −1 1 −1 1 1 −1 −1 1 −1 −1 1 1 1 1 1 1 −1 1 −1 −1 1 1 |
| | −1 −1 −1 1 1 −1 1 −1 1 −1 −1 −1 −1 −1 1 1 −1 −1 −1 1 1 −1 1 −1 1 −1 −1 −1 −1 |
| | 1 1 −1 −1 1 −1 −1 1 1 1 1 1 1 −1 1 −1 −1 −1 1 1 −1 1 1 −1 −1 −1 −1 −1 −1 1 −1 |
| | 1 −1 1 1 −1 −1 −1 1 1 −1 1 −1 1 −1 −1 −1 −1 1 −1 −1 1 1 1 −1 −1 1 −1 1 −1 1 1 |
| | 1 1 −1 −1 1 1 −1 1 1 −1 −1 −1 −1 −1 −1 1 −1 1 −1 −1 1 1 −1 1 1 −1 −1 −1 −1 −1 |
| | −1 1 −1 1 1 −1 −1 1 1 1 −1 −1 1 −1 1 −1 1 1 1 1 1 −1 −1 1 1 1 −1 −1 1 −1 1 −1 1 |
| | 1 1 1 −1 −1 1 1 −1 1 1 −1 −1 −1 −1 −1 −1 1 −1 1 1 1 −1 −1 1 −1 −1 1 1 1 1 1 1 |
| | −1 1 −1 1 −1 −1 1 1 1 −1 −1 1 −1 1 −1 1 1 1 1 −1 1 1 −1 −1 −1 1 1 −1 1 −1 1 −1 |
| | −1 −1 −1 1 1 1 1 −1 1 −1 1 1 1 −1 −1 −1 1 1 −1 −1 −1 −1 −1 1 −1 1 −1 −1 −1 1 1 |
| | 1 −1 −1 1 1 −1 1 −1 −1 −1 −1 −1 1 −1 −1 1 −1 −1 1 1 −1 1 −1 1 1 1 1 1 −1 1 1 |
| | −1 1 1 −1 −1 1 1 1 1 −1 1 −1 1 1 1 −1 −1 −1 1 1 −1 1 1 1 1 −1 1 −1 1 1 1 −1 −1 |
| | −1 1 1 −1 1 −1 1 −1 −1 −1 −1 −1 1 −1 −1 1 −1 −1 1 1 1 −1 1 −1 −1 −1 −1 −1 1 |
| | −1 −1 1 −1 −1 1 1 −1 −1 −1 −1 1 −1 1 −1 −1 −1 1 1 1 −1 −1 1 1 1 1 1 −1 1 −1 1 |
| | 1 1 −1 −1 −1 1 1 −1 −1 1 −1 1 1 1 1 1 −1 1 1 −1 1 1 −1 −1 1 −1 1 −1 −1 −1 −1 |
| | −1 1 −1 −1 1 −1 −1 1 1 −1 −1 −1 −1 1 −1 1 −1 −1 −1 1 1 1 −1 −1 1 −1 −1 −1 −1 |
| | 1 −1 1 −1 −1 −1 1 1 1 −1 −1 1 −1 1 −1 1 1 1 1 1 −1 1 1 −1 1 1 −1 −1 −1 1 −1 1 1 |
| | 1 1 1 −1 1 1 −1 1 1 −1 −1 1 1 −1 −1 −1 1 1 −1 1 1 1 1 −1 1 −1 1 −1 −1 1 1 1 −1 |
| | −1 1 −1 −1 −1 −1 1 −1 1 −1 −1 1 1 −1 1 1 −1 −1 −1 1 −1 1 1 1 1 1 −1 −1 1 −1 |
| | −1 1 1 1 −1 1 −1 −1 −1 −1 −1 1 1 −1 −1 −1 1 1 −1 1 1 1 1 −1 1 −1 1 1 1 −1 −1 |
| | −1 1 1 −1 1 1 1 1 −1 1 −1 1 −1 1 1 −1 1 1 −1 −1 −1 1 −1 1 1 1 −1 1 1 −1 1 1 |
| | −1 −1 −1 1 −1 1 1 1 1 1 −1 −1 1 1 1 −1 −1 1 −1 −1 −1 −1 1 −1 1 −1 1 1 −1 −1 −1 |
| | 1 1 −1 1 1 1 1 −1 1 −1 1 1 −1 −1 1 −1 −1 1 1 1 −1 1 −1 −1 −1 −1 −1 −1 1 1 −1 1 |
| | 1 −1 −1 −1 1 −1 1 1 1 1 1 −1 −1 1 1 1 −1 −1 1 −1 −1 −1 −1 1 −1 1 −1 −1 −1 1 1 |
| | 1 −1 −1 1 −1 −1 −1 −1 1 −1 1 −1 1 −1 −1 1 −1 −1 1 1 1 −1 1 −1 −1 −1 −1 −1 1 |
| | −1 −1 1 −1 −1 1 1 1 −1 1 −1 −1 −1 −1 −1 1 1 1 1 1 −1 1 −1 1 1 −1 −1 1 −1 −1 1 |
| | 1 1 1 1 1 −1 1 −1 1 1 −1 −1 1 −1 −1 1 1 −1 1 −1 1 1 1 1 1 −1 −1 1 1 1 −1 −1 1 −1 |
| | 1 −1 1 1 1 1 1 −1 1 1 1 −1 −1 −1 −1 −1 −1 −1 1 −1 1 −1 −1 1 1 −1 1 1 −1 1 1 |
| | 1 1 1 −1 1 −1 1 1 −1 −1 1 −1 −1 1 −1 1 −1 1 −1 −1 −1 −1 −1 1 1 −1 −1 −1 1 1 1 |
| | −1 1 −1 1 1 1 1 1 −1 −1 1 1 1 −1 −1 1 1 1 1 1 −1 1 −1 1 1 −1 −1 1 −1 −1 1 1 1 1 |
| | 1 1 −1 1 −1 1 1 −1 −1 1 −1 −1 1 1 −1 1 −1 1 1 1 1 1 −1 −1 1 1 1 −1 −1 1 −1 1 −1 |
| | 1 1 1 1 1 −1 −1 1 1 1 −1 −1 −1 −1 −1 −1 −1 1 −1 1 −1 −1 1 1 −1 1 1 −1 1 1 1 1 1 |
| | −1 1 −1 1 1 −1 −1 1 −1 −1 1 −1 1 −1 1 −1 −1 −1 −1 −1 1 1 −1 −1 −1 1 1 1 −1 1 |
| | −1 1 1 1 1 1 −1 −1 1 1 1 −1 −1 1 1 −1 −1 1 −1 −1 1 1 1 1 1 1 −1 1 −1 1 1 −1 −1 1 |
| | −1 −1 1 1 1 1 1 1 −1 1 −1 −1 1 1 −1 −1 −1 1 1 −1 1 −1 1 −1 −1 −1 −1 −1 1 1 −1 |
| | −1 −1 1 1 −1 1 −1 1 −1 −1 −1 −1 −1 −1 1 1 −1 1 1 −1 −1 −1 −1 −1 −1 1 −1 1 1 1 |
| | −1 −1 1 −1 −1 1 1 1 1 1 1 −1 1 −1 1 −1 −1 1 1 1 −1 −1 1 −1 1 −1 1 1 1 1 −1 1 1 |
| | −1 −1 −1 1 1 −1 1 −1 1 −1 −1 −1 −1 1 1 −1 −1 1 −1 −1 1 1 1 1 1 1 −1 1 −1 1 1 |
| | −1 −1 1 −1 −1 1 1 1 1 1 1 −1 1 −1 −1 1 1 −1 −1 −1 1 1 −1 1 −1 1 −1 −1 −1 −1 −1 |
| | 1 1 −1 −1 −1 1 1 −1 1 −1 1 −1 −1 −1 −1 −1 −1 1 1 −1 1 1 −1 −1 −1 −1 −1 −1 1 |
| | −1 1 1 1 −1 −1 1 −1 −1 1 1 1 1 1 1 −1 1 −1 1 −1 −1 1 1 1 −1 −1 1 −1 1 −1 1 1 1 1 |
| | −1 1 1 −1 −1 −1 1 1 −1 1 −1 1 −1 −1 −1 −1 1 1 1 1 −1 1 −1 1 1 1 −1 −1 −1 1 1 |
| | −1 −1 −1 −1 −1 1 −1 1 −1 −1 −1 1 1 1 −1 −1 1 1 −1 1 −1 −1 −1 −1 −1 1 −1 −1 1 |
| | −1 −1 1 1 −1 1 −1 1 1 1 1 1 −1 1 1 −1 1 1 −1 −1 −1 −1 −1 −1 1 −1 1 −1 −1 −1 1 |
| | 1 1 −1 −1 1 −1 −1 −1 −1 1 −1 1 −1 −1 −1 1 1 1 −1 −1 1 −1 1 −1 1 1 1 1 1 −1 1 1 |
| | −1 1 1 −1 −1 −1 1 −1 1 1 1 1 1 −1 1 1 −1 1 1 −1 −1 1 1 1 1 −1 1 −1 1 1 1 −1 −1 |
| | −1 1 1 −1 −1 −1 −1 −1 1 −1 1 −1 −1 −1 1 1 1 −1 −1 1 1 −1 1 −1 −1 −1 −1 −1 1 |
| | −1 −1 1 −1 −1 1 1 −1 1 −1 1 1 1 1 1 −1 1 1 −1 1 1 −1 −1 −1 −1 −1 −1 1 −1 1 −1 |
| | −1 −1 1 1 1 −1 −1 −1 −1 −1 1 −1 1 −1 −1 −1 1 1 1 −1 −1 1 −1 1 −1 1 1 1 1 |
| | 1 −1 1 1 −1 1 1 −1 −1 −1 1 −1 1 1 1 1 1 −1 1 1 −1 1 1 −1 −1 1 1 −1 −1 −1 1 1 −1 |
| | 1 1 1 1 −1 1 −1 1 −1 −1 1 1 1 −1 −1 1 −1 −1 −1 −1 1 −1 1 −1 −1 1 1 −1 1 1 −1 |
| | −1 −1 1 −1 1 1 1 1 1 1 −1 −1 1 −1 −1 1 1 1 −1 1 −1 −1 −1 −1 −1 −1 −1 1 1 1 −1 |
| | −1 1 −1 −1 −1 −1 1 −1 1 −1 −1 −1 1 1 1 −1 −1 1 −1 −1 −1 −1 1 −1 1 −1 1 −1 −1 |
| | 1 −1 −1 1 1 1 −1 1 −1 −1 −1 −1 −1 1 −1 −1 1 −1 −1 1 1 1 −1 1 −1 −1 −1 −1 −1 1 |
| | 1 −1 −1 −1 1 1 −1 1 1 1 1 −1 1 −1 1 −1 −1 1 1 1 −1 −1 1 −1 −1 −1 −1 1 −1 1 −1 |
| | −1 1 1 −1 1 1 −1 −1 −1 1 −1 1 1 1 1 1 1 −1 −1 1 −1 −1 1 1 1 −1 1 −1 −1 −1 −1 |
| | −1 −1 −1 1 1 1 −1 −1 1 −1 −1 −1 −1 1 −1 1 −1 −1 −1 1 1 1 −1 −1 1 −1 −1 −1 −1 |
| | 1 −1 1 −1 1 −1 −1 1 −1 −1 1 1 1 −1 1 −1 −1 −1 −1 −1 1 −1 −1 1 −1 −1 1 1 1 −1 1 |
| | −1 −1 −1 −1 −1 |
| 12 | 1 1 1 −1 1 1 1 −1 1 1 1 −1 −1 −1 −1 1 1 1 −1 1 1 1 −1 1 1 1 −1 1 −1 −1 1 −1 1 1 |
| | 1 −1 1 1 1 −1 1 1 1 −1 −1 −1 −1 1 1 1 −1 1 1 1 −1 1 1 1 −1 1 −1 −1 1 −1 1 1 1 −1 |
| | 1 1 1 −1 1 1 1 −1 −1 −1 −1 1 1 1 −1 1 1 1 −1 1 1 1 −1 1 −1 −1 1 −1 1 1 1 −1 1 1 |
| | 1 −1 1 1 1 −1 −1 −1 −1 1 1 1 −1 1 1 1 −1 1 1 1 −1 1 −1 −1 1 −1 1 −1 1 1 1 −1 1 1 |
| | 1 −1 1 1 −1 1 −1 −1 1 −1 −1 −1 1 −1 −1 −1 1 −1 −1 −1 −1 1 1 1 1 −1 1 1 1 −1 1 |
| | 1 1 −1 1 1 −1 1 −1 −1 1 −1 −1 −1 1 −1 −1 −1 1 −1 −1 −1 −1 1 1 1 1 −1 1 1 1 −1 |
| | 1 1 1 −1 1 1 −1 1 −1 −1 1 −1 −1 −1 1 −1 −1 −1 1 −1 −1 −1 −1 1 1 1 1 −1 1 1 1 |
| | −1 1 1 1 −1 1 1 −1 1 −1 −1 1 −1 −1 −1 1 −1 −1 −1 1 −1 −1 −1 −1 1 1 1 1 1 1 −1 |
| | 1 1 1 −1 −1 −1 −1 1 1 1 1 −1 −1 −1 1 −1 −1 −1 1 −1 1 1 −1 1 −1 −1 1 −1 1 1 1 |
| | −1 1 1 1 −1 −1 −1 −1 1 1 1 1 −1 −1 −1 1 −1 −1 −1 1 −1 1 1 −1 1 −1 −1 1 −1 1 1 |
| | 1 −1 1 1 1 −1 −1 −1 −1 1 1 1 1 −1 −1 −1 1 −1 −1 −1 1 −1 1 1 −1 1 −1 −1 1 −1 1 |
| | 1 1 −1 1 1 1 −1 −1 −1 −1 1 1 1 1 −1 −1 −1 1 −1 −1 −1 1 −1 1 1 −1 1 −1 −1 1 −1 |
| | 1 −1 1 1 1 −1 1 1 −1 1 −1 −1 1 −1 1 1 −1 1 1 1 −1 1 1 1 1 −1 −1 −1 1 1 1 1 1 −1 |
| | 1 1 1 −1 1 1 −1 1 −1 −1 1 −1 1 1 −1 1 1 1 −1 1 1 1 1 −1 −1 −1 −1 1 1 1 1 −1 1 1 |
| | 1 −1 1 1 −1 1 −1 −1 1 −1 1 1 −1 1 1 1 −1 1 1 1 1 −1 −1 −1 −1 1 1 1 1 −1 1 1 1 −1 |
| | 1 1 −1 1 −1 −1 1 −1 1 1 −1 1 1 1 −1 1 1 1 1 −1 −1 −1 −1 1 1 1 1 1 −1 −1 −1 −1 |
| | 1 1 1 1 −1 1 1 1 −1 1 1 −1 1 −1 −1 1 −1 1 1 −1 1 1 1 −1 1 −1 −1 −1 1 1 1 1 −1 −1 |
| | −1 −1 1 −1 −1 −1 1 −1 −1 1 −1 1 1 −1 1 −1 −1 1 −1 −1 −1 1 −1 1 1 1 −1 −1 −1 |
| | −1 1 1 1 1 −1 1 1 1 −1 1 1 −1 1 −1 −1 1 −1 1 1 −1 1 1 1 −1 1 −1 −1 −1 1 1 1 1 −1 |
| | −1 −1 −1 1 −1 −1 −1 1 −1 −1 1 −1 1 1 −1 1 −1 −1 1 −1 −1 −1 1 −1 1 −1 1 1 −1 1 |
| | −1 −1 1 −1 1 1 1 −1 1 1 1 −1 −1 −1 −1 1 1 1 1 −1 −1 −1 1 −1 −1 −1 −1 1 −1 −1 1 |
| | −1 1 1 −1 1 −1 −1 −1 1 −1 −1 −1 1 1 1 1 −1 −1 −1 −1 1 1 1 −1 1 1 1 1 −1 1 1 −1 |
| | 1 −1 −1 1 −1 1 1 1 −1 1 1 1 −1 −1 −1 −1 1 1 1 1 −1 −1 −1 1 −1 −1 −1 −1 1 −1 −1 |
| | 1 −1 1 1 −1 1 −1 −1 −1 1 −1 −1 −1 1 1 1 1 −1 −1 −1 −1 1 1 1 −1 1 1 1 1 1 1 −1 |
| | −1 −1 −1 1 −1 −1 −1 1 −1 −1 −1 1 −1 −1 1 −1 1 1 −1 1 1 1 −1 1 1 1 −1 1 −1 −1 |
| | −1 1 1 1 1 −1 1 1 1 −1 1 1 1 −1 1 1 −1 1 −1 −1 1 −1 −1 −1 1 −1 −1 −1 1 −1 1 1 1 |
| | −1 −1 −1 −1 1 −1 −1 −1 1 −1 −1 −1 1 −1 −1 1 −1 1 1 −1 1 1 1 −1 1 1 1 −1 1 −1 |
| | −1 −1 1 1 1 1 −1 1 1 1 −1 1 1 1 −1 1 1 −1 1 −1 −1 1 −1 −1 −1 1 −1 −1 −1 1 −1 1 |
| | −1 1 1 −1 1 −1 −1 −1 1 −1 −1 −1 1 −1 −1 −1 1 1 1 1 −1 −1 −1 1 −1 −1 −1 1 −1 |
| | −1 −1 −1 1 −1 −1 1 −1 1 1 1 −1 1 1 1 −1 1 1 1 −1 −1 −1 −1 1 1 1 −1 1 1 1 −1 1 1 |
| | 1 1 −1 1 1 −1 1 −1 −1 −1 1 −1 −1 −1 1 −1 −1 −1 1 1 1 1 −1 −1 −1 1 −1 −1 −1 1 |
| | −1 −1 −1 −1 1 −1 −1 1 −1 1 1 1 −1 1 1 1 −1 1 1 1 −1 −1 −1 −1 1 1 1 −1 1 1 1 −1 |
| | 1 1 1 1 1 1 −1 1 1 1 −1 1 1 1 −1 −1 −1 −1 1 1 1 −1 1 1 1 −1 1 1 1 −1 1 −1 −1 1 |
| | −1 1 1 1 −1 1 1 1 −1 1 1 1 −1 −1 −1 −1 1 1 1 −1 1 1 1 −1 1 1 1 −1 1 −1 −1 1 −1 |
| | −1 −1 −1 1 −1 −1 −1 1 −1 −1 −1 1 1 1 1 −1 −1 −1 1 −1 −1 −1 1 −1 −1 −1 1 −1 1 |
| | 1 −1 1 −1 −1 −1 1 −1 −1 −1 1 −1 −1 −1 1 1 1 1 −1 −1 −1 1 −1 −1 −1 1 −1 −1 −1 |
| | 1 −1 1 1 −1 1 −1 1 −1 −1 −1 1 −1 −1 −1 1 −1 −1 1 −1 1 1 −1 1 1 1 −1 1 1 1 −1 1 |
| | 1 1 1 −1 −1 −1 −1 1 −1 −1 −1 1 −1 −1 −1 1 −1 −1 1 −1 1 1 −1 1 1 1 −1 1 1 1 −1 |
| | 1 1 1 1 −1 −1 −1 1 −1 1 1 1 −1 1 1 1 −1 1 1 −1 1 −1 −1 1 −1 −1 −1 1 −1 −1 −1 1 |
| | −1 −1 −1 −1 1 1 1 1 −1 1 1 1 −1 1 1 1 −1 1 1 −1 1 −1 −1 1 −1 −1 −1 1 −1 −1 −1 |
| | 1 −1 −1 −1 −1 1 1 1 1 1 1 −1 1 1 1 −1 −1 −1 −1 1 1 1 1 −1 −1 −1 1 −1 −1 −1 1 |
| | −1 1 1 −1 1 −1 −1 1 −1 1 1 1 −1 1 1 1 −1 −1 −1 −1 1 1 1 1 −1 −1 −1 1 −1 −1 −1 |
| | 1 −1 1 1 −1 1 −1 −1 1 −1 −1 −1 −1 1 −1 −1 −1 1 1 1 1 −1 −1 −1 −1 1 1 1 −1 1 1 |
| | 1 −1 1 −1 −1 1 −1 1 1 −1 1 −1 −1 −1 1 −1 −1 −1 1 1 1 1 −1 −1 −1 −1 1 1 1 −1 1 |
| | 1 1 −1 1 −1 −1 1 −1 1 1 −1 1 −1 1 −1 −1 −1 1 −1 −1 1 −1 1 1 −1 1 −1 −1 1 −1 −1 |
| | −1 1 −1 −1 −1 −1 1 1 1 1 −1 −1 −1 −1 1 −1 −1 −1 1 −1 −1 1 −1 1 1 −1 1 −1 −1 1 |
| | −1 −1 −1 1 −1 −1 −1 −1 1 1 1 1 −1 −1 −1 1 −1 1 1 1 −1 1 1 −1 1 −1 −1 1 −1 1 1 |
| | −1 1 1 1 −1 1 1 1 1 −1 −1 −1 −1 1 1 1 1 −1 1 1 1 −1 1 1 −1 1 −1 −1 1 −1 1 1 −1 1 |
| | 1 1 −1 1 1 1 1 −1 −1 −1 −1 1 1 1 1 1 1 −1 −1 −1 −1 1 1 1 1 −1 1 1 1 −1 1 1 −1 1 |
| | −1 −1 1 −1 1 1 −1 1 1 1 −1 1 −1 −1 −1 1 1 1 1 −1 −1 −1 −1 1 −1 −1 −1 1 −1 −1 1 |
| | −1 1 1 −1 1 −1 −1 1 −1 −1 −1 1 −1 −1 −1 −1 1 1 1 1 −1 −1 −1 −1 1 −1 −1 −1 1 |
| | −1 −1 1 −1 1 1 −1 1 −1 −1 1 −1 −1 −1 1 −1 1 1 1 −1 −1 −1 −1 1 1 1 1 −1 1 1 1 |
| | −1 1 1 −1 1 −1 −1 1 −1 1 1 −1 1 1 1 −1 1 −1 1 −1 −1 1 −1 1 1 −1 1 −1 −1 −1 1 |
| | −1 −1 −1 1 1 1 1 −1 −1 −1 −1 1 1 1 −1 1 1 1 1 −1 1 1 −1 1 −1 −1 1 −1 1 1 1 −1 1 |
| | 1 1 −1 −1 −1 −1 1 1 1 1 −1 −1 −1 1 −1 −1 −1 1 −1 1 1 −1 1 −1 −1 1 −1 1 1 1 −1 |
| | 1 1 1 −1 −1 −1 −1 1 1 1 1 −1 −1 −1 1 −1 −1 −1 −1 1 −1 −1 1 1 1 −1 1 −1 −1 |
| | −1 1 −1 −1 −1 1 1 1 1 −1 −1 −1 −1 1 1 1 −1 1 1 1 1 1 1 −1 −1 −1 −1 1 −1 −1 −1 |
| | 1 −1 −1 −1 1 −1 −1 1 −1 1 1 −1 1 1 1 −1 1 1 1 −1 1 −1 −1 −1 1 1 1 1 −1 1 1 1 −1 |
| | 1 1 1 −1 1 1 −1 1 −1 −1 1 −1 −1 −1 1 −1 −1 −1 1 −1 −1 −1 −1 1 1 1 1 −1 1 1 1 |
| | −1 1 1 1 −1 1 1 −1 1 −1 −1 1 −1 −1 −1 1 −1 −1 −1 1 −1 1 1 1 −1 −1 −1 −1 1 −1 |
| | −1 −1 1 −1 −1 −1 1 −1 −1 1 −1 1 1 −1 1 1 1 −1 1 1 1 −1 1 −1 1 −1 −1 1 −1 1 1 1 |
| | −1 1 1 1 −1 1 1 1 −1 −1 −1 −1 1 1 1 −1 1 1 1 −1 1 1 1 1 −1 1 1 −1 1 −1 −1 −1 1 |
| | −1 −1 −1 1 −1 −1 −1 1 1 1 1 −1 −1 −1 1 −1 −1 −1 1 −1 −1 −1 1 −1 1 1 −1 1 −1 |
| | −1 −1 1 −1 −1 −1 1 −1 −1 −1 1 1 1 1 −1 −1 −1 1 −1 −1 −1 1 −1 −1 −1 −1 1 −1 |
| | −1 1 −1 1 1 1 −1 1 1 1 −1 1 1 1 −1 −1 −1 −1 1 1 1 −1 1 1 1 −1 1 1 1 1 1 1 −1 1 1 |
| | 1 −1 1 1 1 −1 −1 −1 −1 1 1 1 −1 1 1 1 −1 1 1 1 −1 1 −1 −1 1 −1 1 1 1 −1 1 1 1 −1 |
| | 1 1 1 −1 −1 −1 −1 1 1 1 −1 1 1 1 −1 1 1 1 −1 1 −1 −1 1 −1 −1 −1 −1 1 −1 −1 −1 |
| | 1 −1 −1 −1 1 1 1 1 −1 −1 −1 1 −1 −1 −1 1 −1 −1 −1 1 −1 1 1 −1 1 −1 −1 −1 1 −1 |
| | −1 −1 1 −1 −1 −1 1 1 1 1 −1 −1 −1 1 −1 −1 −1 1 −1 −1 −1 1 −1 1 1 −1 1 1 −1 1 1 |
| | 1 −1 1 1 1 −1 1 1 −1 1 −1 −1 1 −1 −1 −1 1 −1 −1 −1 1 −1 −1 −1 −1 1 1 1 1 −1 1 |
| | 1 1 −1 1 1 1 −1 1 1 −1 1 −1 −1 1 −1 −1 −1 1 −1 −1 −1 1 −1 −1 −1 −1 1 1 1 −1 1 |
| | −1 −1 −1 1 −1 −1 −1 1 −1 −1 1 −1 1 1 −1 1 1 1 −1 1 1 1 −1 1 1 1 1 −1 −1 −1 −1 |
| | 1 −1 −1 −1 1 −1 −1 −1 1 −1 −1 1 −1 1 1 −1 1 1 1 −1 1 1 1 −1 1 1 1 1 −1 −1 −1 1 |
| | 1 1 −1 1 1 1 −1 −1 −1 −1 1 1 1 1 −1 −1 −1 1 −1 −1 −1 1 −1 1 1 −1 1 −1 −1 1 −1 |
| | 1 1 1 −1 1 1 1 −1 −1 −1 −1 1 1 1 1 −1 −1 −1 1 −1 −1 −1 1 −1 1 1 −1 1 −1 −1 1 |
| | −1 −1 −1 −1 1 −1 −1 −1 1 1 1 1 −1 −1 −1 −1 1 1 1 −1 1 1 1 −1 1 −1 −1 1 −1 1 1 |
| | −1 1 −1 −1 −1 1 −1 −1 −1 1 1 1 1 −1 −1 −1 −1 1 1 1 −1 1 1 1 −1 1 −1 −1 1 −1 1 |
| | 1 −1 1 1 −1 1 1 1 −1 1 1 −1 1 −1 −1 1 −1 1 1 −1 1 1 1 −1 1 1 1 1 −1 −1 −1 −1 1 1 |
| | 1 1 −1 1 1 1 −1 1 1 −1 1 −1 −1 1 −1 1 1 −1 1 1 1 1 1 1 −1 −1 −1 −1 1 1 1 −1 |
| | 1 −1 −1 −1 1 −1 −1 1 −1 1 1 −1 1 −1 −1 1 −1 −1 −1 1 −1 −1 −1 −1 1 1 1 1 −1 −1 |
| | −1 −1 1 −1 −1 −1 1 −1 −1 1 −1 1 1 −1 1 −1 −1 1 −1 −1 −1 1 −1 −1 −1 −1 1 1 1 1 |
| | −1 −1 −1 1 1 1 −1 −1 −1 −1 1 1 1 1 −1 1 1 1 −1 1 1 −1 1 −1 −1 1 −1 1 1 −1 1 1 1 |
| | −1 1 −1 −1 −1 1 1 1 1 −1 −1 −1 −1 1 −1 −1 −1 1 −1 −1 1 −1 1 1 −1 1 −1 −1 1 −1 |
| | −1 −1 1 −1 −1 −1 −1 1 1 1 1 −1 −1 −1 −1 1 −1 −1 −1 1 −1 −1 1 −1 1 1 −1 1 −1 |
| | −1 1 −1 −1 −1 1 −1 1 1 1 −1 −1 −1 −1 1 1 1 1 −1 1 1 1 −1 1 1 −1 1 −1 −1 1 −1 1 |
| | 1 −1 1 1 1 −1 1 1 −1 1 1 −1 1 −1 −1 1 −1 1 1 1 −1 1 1 1 −1 −1 −1 −1 1 1 1 1 −1 |
| | −1 −1 1 −1 −1 −1 −1 1 −1 −1 1 −1 1 1 −1 1 −1 −1 −1 1 −1 −1 −1 1 1 1 1 −1 −1 |
| | −1 −1 1 1 1 −1 1 1 1 −1 1 −1 −1 1 −1 1 1 −1 1 −1 −1 −1 1 −1 −1 −1 1 1 1 1 −1 |
| | −1 −1 −1 1 1 1 −1 1 1 1 1 −1 1 1 −1 1 −1 −1 1 −1 1 1 1 −1 1 1 1 −1 −1 −1 −1 1 1 |
| | 1 1 −1 1 1 1 −1 1 1 1 −1 1 −1 −1 −1 1 1 1 1 −1 1 1 1 −1 1 1 1 −1 1 1 −1 1 −1 −1 |
| | 1 1 −1 1 1 1 −1 1 1 1 −1 1 −1 −1 −1 1 1 1 1 −1 1 1 1 −1 1 1 1 −1 1 1 −1 1 −1 −1 |
| | 1 −1 −1 −1 1 −1 −1 −1 1 −1 −1 −1 −1 1 1 1 1 −1 1 1 1 −1 1 1 1 −1 1 1 −1 1 −1 |
| | −1 1 −1 −1 −1 1 −1 −1 −1 1 −1 1 1 1 −1 −1 −1 −1 1 −1 −1 −1 1 −1 −1 −1 1 −1 |
| | −1 1 −1 1 1 −1 1 1 1 −1 1 1 1 −1 1 1 −1 1 1 −1 1 −1 −1 −1 1 −1 −1 −1 1 −1 −1 |
| | −1 1 1 1 1 −1 −1 −1 1 −1 −1 −1 1 −1 −1 −1 −1 1 −1 −1 1 −1 1 1 1 −1 1 1 1 −1 1 |
| | 1 1 −1 −1 −1 −1 1 1 1 −1 1 1 1 −1 1 1 1 −1 1 −1 −1 1 −1 1 1 1 −1 1 1 1 −1 1 1 1 |
| | −1 −1 −1 −1 1 1 1 −1 1 1 1 −1 1 1 1 1 −1 1 1 −1 1 −1 −1 −1 1 −1 −1 −1 1 −1 −1 |
| | −1 1 1 1 1 −1 −1 −1 1 −1 −1 −1 1 −1 −1 −1 1 1 1 −1 1 1 1 −1 1 1 1 −1 −1 −1 −1 |
| | 1 1 1 −1 1 1 1 −1 1 1 1 −1 1 −1 −1 1 −1 1 1 1 −1 1 1 1 −1 1 1 1 −1 −1 −1 −1 1 1 |
| | 1 −1 1 1 1 −1 1 1 1 −1 1 −1 −1 1 −1 1 1 1 −1 1 1 1 −1 1 1 1 −1 −1 −1 −1 1 1 1 −1 |
| | 1 1 1 −1 1 1 1 −1 1 −1 −1 1 −1 1 1 1 −1 1 1 1 −1 1 1 1 −1 −1 −1 −1 1 1 1 −1 1 1 |
| | 1 −1 1 1 1 −1 1 −1 −1 1 −1 −1 1 −1 −1 −1 1 −1 −1 −1 1 −1 −1 1 −1 1 1 −1 1 1 1 |
| | −1 1 1 1 −1 1 1 1 1 −1 −1 −1 −1 1 −1 −1 −1 1 −1 −1 −1 1 −1 −1 1 −1 1 1 −1 1 1 |
| | 1 −1 1 1 1 −1 1 1 1 1 −1 −1 −1 −1 1 −1 −1 −1 1 −1 −1 −1 1 −1 −1 1 −1 1 1 −1 1 |
| | 1 1 −1 1 1 1 −1 1 1 1 1 −1 −1 −1 −1 1 −1 −1 −1 1 −1 −1 −1 1 −1 −1 1 −1 1 1 −1 |
| | 1 1 1 −1 1 1 1 −1 1 1 1 1 −1 −1 −1 1 1 1 −1 1 1 1 −1 −1 −1 −1 1 1 1 1 −1 −1 −1 1 |
| | −1 −1 −1 1 −1 1 1 −1 1 −1 −1 1 −1 1 1 1 −1 1 1 1 −1 −1 −1 −1 1 1 1 1 −1 −1 −1 |
| | 1 −1 −1 −1 1 −1 1 1 −1 1 −1 −1 1 −1 1 1 1 −1 1 1 1 −1 −1 −1 −1 1 1 1 1 −1 −1 |
| | −1 1 −1 −1 −1 1 −1 1 1 −1 1 −1 −1 1 −1 1 1 1 −1 1 1 1 −1 −1 −1 −1 1 1 1 1 −1 |
| | −1 −1 1 −1 −1 −1 1 −1 1 1 −1 1 −1 −1 1 −1 −1 1 −1 −1 −1 1 −1 −1 1 −1 1 1 −1 1 |
| | −1 −1 1 −1 −1 −1 1 −1 −1 −1 −1 1 1 1 1 −1 −1 −1 −1 1 −1 −1 −1 1 −1 −1 1 −1 1 |
| | 1 −1 1 −1 −1 1 −1 −1 −1 1 −1 −1 −1 −1 1 1 1 1 −1 −1 −1 −1 1 −1 −1 −1 1 −1 −1 |
| | 1 −1 1 1 −1 1 −1 −1 1 −1 −1 −1 1 −1 −1 −1 −1 1 1 1 1 −1 −1 −1 −1 1 −1 −1 −1 1 |
| | −1 −1 1 −1 1 1 −1 1 −1 −1 1 −1 −1 −1 1 −1 −1 −1 −1 1 1 1 1 −1 −1 −1 1 1 1 −1 |
| | −1 −1 −1 1 1 1 1 −1 1 1 1 −1 1 1 −1 1 −1 −1 1 −1 1 1 −1 1 1 1 −1 1 −1 −1 −1 1 1 |
| | 1 1 −1 −1 −1 −1 1 −1 −1 −1 1 −1 −1 1 −1 1 1 −1 1 −1 −1 1 −1 −1 −1 1 −1 1 1 1 |
| | −1 −1 −1 −1 1 1 1 1 −1 1 1 1 −1 1 1 −1 1 −1 −1 1 −1 1 1 −1 1 1 1 −1 1 −1 −1 −1 |
| | 1 1 1 1 −1 −1 −1 −1 1 −1 −1 −1 1 −1 −1 1 −1 1 1 −1 1 −1 −1 1 −1 −1 −1 1 −1 −1 |
| | 1 −1 −1 1 −1 1 1 −1 1 −1 −1 −1 1 −1 −1 −1 1 1 1 1 −1 −1 −1 −1 1 1 1 −1 1 1 1 1 |
| | −1 1 1 −1 1 −1 −1 1 −1 1 1 1 −1 1 1 1 −1 −1 −1 −1 1 1 1 1 −1 −1 −1 1 −1 −1 −1 |
| | −1 1 −1 −1 1 −1 1 1 −1 1 −1 −1 −1 1 −1 −1 −1 1 1 1 1 −1 −1 −1 −1 1 1 1 −1 1 1 |
| | 1 1 −1 1 1 −1 1 −1 −1 1 −1 1 1 1 −1 1 1 1 −1 −1 −1 −1 1 1 1 1 −1 −1 −1 1 −1 −1 |
| | −1 1 1 1 −1 −1 −1 −1 1 −1 −1 −1 1 −1 −1 −1 1 −1 −1 1 −1 1 1 −1 1 1 1 −1 1 1 1 |
| | −1 1 −1 −1 −1 1 1 1 1 −1 1 1 1 −1 1 1 1 −1 1 1 −1 1 −1 −1 1 −1 −1 −1 1 −1 −1 |
| | −1 1 −1 1 1 1 −1 −1 −1 −1 1 −1 −1 −1 1 −1 −1 −1 1 −1 −1 1 −1 1 1 −1 1 1 1 −1 1 |
| | 1 1 −1 1 −1 −1 −1 1 1 1 1 −1 1 1 1 −1 1 1 1 −1 1 1 −1 1 −1 −1 1 −1 −1 −1 1 −1 |
| | −1 −1 1 −1 −1 1 −1 −1 1 −1 1 1 1 −1 1 1 1 −1 1 1 1 −1 −1 −1 −1 1 1 1 −1 1 1 1 |
| | −1 1 1 1 1 −1 1 1 −1 1 −1 −1 −1 1 −1 −1 −1 1 −1 −1 −1 1 1 1 1 −1 −1 −1 1 −1 −1 |
| | −1 1 −1 −1 −1 1 1 −1 −1 1 −1 1 1 1 −1 1 1 1 −1 1 1 1 −1 −1 −1 −1 1 1 1 −1 1 1 |
| | 1 −1 1 1 1 1 −1 1 1 −1 1 −1 −1 −1 1 −1 −1 −1 1 −1 −1 −1 1 1 1 1 −1 −1 −1 1 −1 |
| | −1 −1 1 −1 −1 −1 −1 −1 −1 1 −1 −1 −1 1 −1 −1 −1 1 1 1 1 −1 −1 −1 1 −1 −1 −1 |
| | 1 −1 −1 −1 1 −1 1 1 −1 1 −1 −1 −1 1 −1 −1 −1 1 −1 −1 −1 1 1 1 1 −1 −1 −1 1 −1 |
| | −1 −1 1 −1 −1 −1 1 −1 1 1 −1 1 −1 −1 −1 1 −1 −1 −1 1 −1 −1 −1 1 1 1 1 −1 −1 |
| | −1 1 −1 −1 −1 1 −1 −1 −1 1 −1 1 1 −1 1 −1 −1 −1 1 −1 −1 −1 1 −1 −1 −1 1 1 1 1 |
| | −1 −1 −1 1 −1 −1 −1 1 −1 −1 −1 1 −1 1 1 −1 1 −1 1 −1 −1 −1 1 −1 −1 −1 1 −1 |
| | −1 1 −1 1 1 −1 1 1 1 −1 1 1 1 −1 1 1 1 1 −1 −1 −1 −1 1 −1 −1 −1 1 −1 −1 −1 1 |
| | −1 −1 1 −1 1 1 −1 1 1 1 −1 1 1 1 −1 1 1 1 1 −1 −1 −1 −1 1 −1 −1 −1 1 −1 −1 −1 |
| | 1 −1 −1 1 −1 1 1 −1 1 1 1 −1 1 1 1 −1 1 1 1 1 −1 −1 −1 −1 1 −1 −1 −1 1 −1 −1 |
| | −1 1 −1 −1 1 −1 1 1 −1 1 1 1 −1 1 1 1 −1 1 1 1 1 −1 −1 −1 −1 −1 −1 1 −1 −1 −1 |
| | 1 1 1 1 −1 −1 −1 −1 1 1 1 −1 1 1 1 −1 1 −1 −1 1 −1 1 1 −1 1 −1 −1 −1 1 −1 −1 |
| | −1 1 1 1 1 −1 −1 −1 −1 1 1 1 −1 1 1 1 −1 1 −1 −1 1 −1 1 1 −1 1 −1 −1 −1 1 −1 |
| | −1 −1 1 1 1 1 −1 −1 −1 −1 1 1 1 −1 1 1 1 −1 1 −1 −1 1 −1 1 1 −1 1 −1 −1 −1 1 |
| | −1 −1 −1 1 1 1 1 −1 −1 −1 −1 1 1 1 −1 1 1 1 −1 1 −1 −1 1 −1 1 1 −1 1 −1 1 −1 |
| | −1 −1 1 −1 −1 1 −1 1 1 −1 1 −1 −1 1 −1 −1 −1 1 −1 −1 −1 −1 1 1 1 1 −1 −1 −1 |
| | −1 1 −1 −1 −1 1 −1 −1 1 −1 1 1 −1 1 −1 −1 1 −1 −1 −1 1 −1 −1 −1 −1 1 1 1 1 −1 |
| | −1 −1 −1 1 −1 −1 −1 1 −1 −1 1 −1 1 1 −1 1 −1 −1 1 −1 −1 −1 1 −1 −1 −1 −1 1 1 |
| | 1 1 −1 −1 −1 −1 1 −1 −1 −1 1 −1 −1 1 −1 1 1 −1 1 −1 −1 1 −1 −1 −1 1 −1 −1 −1 |
| | −1 1 1 1 1 −1 −1 −1 −1 −1 −1 1 1 1 1 −1 −1 −1 −1 1 −1 −1 −1 1 −1 −1 1 −1 1 1 |
| | −1 1 −1 −1 1 −1 −1 −1 1 −1 1 1 1 −1 −1 −1 −1 1 1 1 1 −1 1 1 1 −1 1 1 −1 1 −1 |
| | −1 1 −1 1 1 −1 1 1 1 −1 1 −1 −1 −1 1 1 1 1 −1 −1 −1 −1 1 −1 −1 −1 1 −1 −1 1 −1 |
| | 1 1 −1 1 −1 −1 1 −1 −1 −1 1 −1 1 1 1 −1 −1 −1 −1 1 1 1 1 −1 1 1 1 −1 1 1 −1 1 |
| | −1 −1 1 −1 1 1 −1 1 1 1 −1 1 −1 1 −1 −1 1 −1 1 1 −1 1 −1 −1 −1 1 −1 −1 −1 1 1 |
| | 1 1 −1 −1 −1 −1 1 1 1 −1 1 1 1 1 −1 1 1 −1 1 −1 −1 1 −1 1 1 1 −1 1 1 1 −1 −1 −1 |
| | −1 1 1 1 1 −1 −1 −1 1 −1 −1 −1 −1 1 −1 −1 1 −1 1 1 −1 1 −1 −1 −1 1 −1 −1 −1 1 |
| | 1 1 1 −1 −1 −1 −1 1 1 1 −1 1 1 1 1 −1 1 1 −1 1 −1 −1 1 −1 1 1 1 −1 1 1 1 −1 −1 |
| | −1 −1 1 1 1 1 −1 −1 −1 1 −1 −1 −1 −1 −1 −1 1 1 1 1 −1 1 1 1 −1 1 1 1 −1 1 1 −1 |
| | 1 −1 −1 1 −1 −1 −1 1 −1 −1 −1 1 −1 1 1 1 −1 −1 −1 −1 1 −1 −1 −1 1 −1 −1 −1 1 |
| | −1 −1 1 −1 1 1 −1 1 1 1 −1 1 1 1 −1 1 −1 −1 −1 1 1 1 1 −1 1 1 1 −1 1 1 1 −1 1 1 |
| | −1 1 −1 −1 1 −1 −1 −1 1 −1 −1 −1 1 −1 1 1 1 −1 −1 −1 −1 1 −1 −1 −1 1 −1 −1 |
| | −1 1 −1 −1 1 −1 1 1 −1 1 1 1 −1 1 1 1 −1 1 −1 1 −1 −1 1 −1 1 1 1 −1 1 1 1 −1 1 1 |
| | 1 −1 −1 −1 −1 1 1 1 −1 1 1 1 −1 1 1 1 1 −1 1 1 −1 1 −1 −1 −1 1 −1 −1 −1 1 −1 |
| | −1 −1 1 1 1 1 −1 −1 −1 1 −1 −1 −1 1 −1 −1 −1 −1 1 −1 −1 1 −1 1 1 1 −1 1 1 1 −1 |
| | 1 1 1 −1 −1 −1 −1 1 1 1 −1 1 1 1 −1 1 1 1 1 −1 1 1 −1 1 −1 −1 −1 1 −1 −1 −1 1 |
| | −1 −1 −1 1 1 1 1 −1 −1 −1 1 −1 −1 −1 1 −1 −1 −1 −1 −1 −1 1 −1 −1 −1 1 −1 −1 |
| | −1 1 1 1 1 −1 −1 −1 1 −1 −1 −1 1 −1 −1 −1 1 −1 1 1 −1 1 −1 −1 −1 1 −1 −1 −1 1 |
| | −1 −1 −1 1 1 1 1 −1 −1 −1 1 −1 −1 −1 1 −1 −1 −1 1 −1 1 1 −1 1 1 1 1 −1 1 1 1 |
| | −1 1 1 1 −1 −1 −1 −1 1 1 1 −1 1 1 1 −1 1 1 1 −1 1 −1 −1 1 −1 1 1 1 −1 1 1 1 −1 1 |
| | 1 1 −1 −1 −1 −1 1 1 1 −1 1 1 1 −1 1 1 1 −1 1 −1 −1 1 −1 1 −1 1 1 1 −1 1 1 1 −1 1 |
| | 1 −1 1 −1 −1 1 −1 −1 −1 1 −1 −1 −1 1 −1 −1 −1 −1 1 1 1 1 −1 1 1 1 −1 1 1 1 −1 |
| | 1 1 −1 1 −1 −1 1 −1 −1 −1 1 −1 −1 −1 1 −1 −1 −1 −1 1 1 1 −1 1 −1 −1 −1 1 −1 |
| | −1 −1 1 −1 −1 1 −1 1 1 −1 1 1 1 −1 1 1 1 −1 1 1 1 1 −1 −1 −1 −1 1 −1 −1 −1 1 |
| | −1 −1 −1 1 −1 −1 1 −1 1 1 −1 1 1 1 −1 1 1 1 −1 1 1 1 1 −1 −1 −1 −1 −1 −1 1 −1 |
| | −1 −1 1 1 1 1 −1 −1 −1 1 1 1 −1 1 1 1 −1 1 −1 −1 1 −1 1 1 −1 1 −1 −1 −1 1 |
| | −1 −1 −1 1 1 1 1 −1 −1 −1 −1 1 1 1 −1 1 1 1 −1 1 −1 −1 1 −1 1 1 −1 1 1 1 1 −1 1 |
| | 1 1 −1 −1 −1 −1 1 1 1 1 −1 −1 −1 1 −1 −1 −1 1 −1 1 1 −1 1 −1 −1 1 −1 1 1 1 −1 |
| | 1 1 1 −1 −1 −1 −1 1 1 1 1 −1 −1 −1 1 −1 −1 −1 1 −1 1 1 −1 1 −1 −1 1 −1 1 −1 1 |
| | 1 1 −1 1 1 −1 1 −1 −1 1 −1 1 1 −1 1 1 1 −1 1 1 1 1 −1 −1 −1 −1 1 1 1 1 −1 1 1 1 |
| | −1 1 1 −1 1 −1 −1 1 −1 1 1 −1 1 1 1 −1 1 1 1 1 −1 −1 −1 −1 1 1 1 −1 1 −1 −1 −1 |
| | 1 −1 −1 1 −1 1 1 −1 1 −1 −1 1 −1 −1 −1 1 −1 −1 −1 −1 1 1 1 1 −1 −1 −1 −1 1 −1 |
| | −1 −1 1 −1 −1 1 −1 1 1 −1 1 −1 −1 1 −1 −1 −1 1 −1 −1 −1 −1 1 1 1 1 −1 −1 −1 |
| | −1 −1 −1 1 1 1 1 −1 −1 −1 −1 1 −1 −1 −1 1 −1 −1 1 −1 1 1 −1 1 −1 −1 1 −1 −1 |
| | −1 1 −1 1 1 1 −1 −1 −1 −1 1 1 1 1 −1 1 1 1 −1 1 1 −1 1 −1 −1 1 −1 1 1 −1 1 1 1 |
| | −1 1 1 1 1 −1 −1 −1 −1 1 1 1 1 −1 1 1 1 −1 1 1 −1 1 −1 −1 1 −1 1 1 −1 1 1 1 −1 1 |
| | −1 −1 −1 1 1 1 1 −1 −1 −1 −1 1 −1 −1 −1 1 −1 −1 1 −1 1 1 −1 1 −1 −1 1 −1 −1 |
| | −1 1 −1 1 −1 1 1 −1 1 −1 −1 1 −1 1 1 1 −1 1 1 1 −1 −1 −1 −1 1 1 1 1 −1 −1 −1 1 |
| | −1 −1 −1 −1 1 −1 −1 1 −1 1 1 −1 1 −1 −1 −1 1 −1 −1 −1 1 1 1 1 −1 −1 −1 −1 1 1 |
| | 1 −1 1 1 1 −1 1 −1 −1 1 −1 1 1 −1 1 −1 −1 −1 1 −1 −1 −1 1 1 1 1 −1 −1 −1 −1 1 |
| | 1 1 −1 1 1 1 1 −1 1 1 −1 1 −1 −1 1 −1 1 1 1 −1 1 1 1 −1 −1 −1 −1 1 1 1 1 −1 −1 |
| | −1 1 −1 −1 −1 −1 −1 −1 1 1 1 1 −1 1 1 1 −1 1 1 1 −1 1 1 −1 1 −1 −1 1 −1 −1 −1 |
| | 1 −1 −1 −1 1 −1 1 1 1 −1 −1 −1 −1 1 −1 −1 −1 1 −1 −1 −1 1 −1 −1 1 −1 1 1 −1 1 |
| | 1 1 −1 1 1 1 −1 1 1 1 1 −1 −1 −1 −1 1 −1 −1 −1 1 −1 −1 −1 1 −1 −1 1 −1 1 1 −1 |
| | 1 1 1 −1 1 1 1 −1 1 −1 −1 −1 1 1 1 1 −1 1 1 1 −1 1 1 1 −1 1 1 −1 1 −1 −1 1 −1 −1 |
| | −1 1 −1 −1 −1 1 −1 1 −1 1 1 −1 1 −1 −1 −1 1 −1 −1 −1 1 −1 −1 −1 1 1 1 1 −1 −1 |
| | −1 1 −1 −1 −1 1 −1 −1 −1 −1 1 −1 −1 1 −1 1 1 1 −1 1 1 1 −1 1 1 1 −1 −1 −1 −1 1 |
| | 1 1 −1 1 1 1 −1 1 1 1 −1 1 −1 −1 1 −1 1 1 1 −1 1 1 1 −1 1 1 1 −1 −1 −1 −1 1 1 1 |
| | −1 1 1 1 −1 1 1 1 1 −1 1 1 −1 1 −1 −1 −1 1 −1 −1 −1 1 −1 −1 −1 1 1 1 1 −1 −1 |
| | −1 1 −1 −1 −1 1 −1 −1 −1 1 1 1 −1 1 1 1 −1 1 1 1 −1 −1 −1 −1 1 1 1 −1 1 1 1 −1 |
| | 1 1 1 −1 1 −1 −1 1 −1 1 1 1 −1 1 1 1 −1 1 1 1 −1 −1 −1 −1 1 1 1 −1 1 1 1 −1 1 1 |
| | 1 −1 1 −1 −1 1 −1 −1 −1 −1 1 −1 −1 −1 1 −1 −1 −1 1 1 1 1 −1 −1 −1 1 −1 −1 −1 |
| | 1 −1 −1 −1 1 −1 1 1 −1 1 −1 −1 −1 1 −1 −1 −1 1 −1 −1 −1 1 1 1 1 −1 −1 −1 1 −1 |
| | −1 −1 1 −1 −1 −1 1 −1 1 1 −1 1 1 −1 1 1 1 −1 1 1 1 −1 1 1 −1 1 −1 −1 1 −1 −1 |
| | −1 1 −1 −1 −1 1 −1 −1 −1 −1 1 1 1 1 −1 1 1 1 −1 1 1 1 −1 1 1 −1 1 −1 −1 1 −1 |
| | −1 −1 1 −1 −1 −1 1 −1 −1 −1 −1 1 1 1 −1 1 −1 −1 −1 1 −1 −1 −1 1 −1 −1 1 −1 1 |
| | 1 −1 1 1 1 −1 1 1 1 −1 1 1 1 1 −1 −1 −1 −1 1 −1 −1 −1 1 −1 −1 −1 1 −1 −1 1 −1 |
| | 1 1 −1 1 1 1 −1 1 1 1 −1 1 1 1 1 −1 −1 −1 1 1 1 −1 1 1 1 −1 −1 −1 −1 1 1 1 1 −1 |
| | −1 −1 1 −1 −1 −1 1 −1 1 1 −1 1 −1 −1 1 −1 1 1 1 −1 1 1 1 −1 −1 −1 −1 1 1 1 1 |
| | −1 −1 −1 1 −1 −1 −1 1 −1 1 1 −1 1 −1 −1 1 −1 −1 −1 −1 1 −1 −1 −1 1 1 1 1 −1 |
| | −1 −1 −1 1 1 1 −1 1 1 1 −1 1 −1 −1 1 −1 1 1 −1 1 −1 −1 −1 1 −1 −1 −1 1 1 1 1 |
| | −1 −1 −1 −1 1 1 −1 1 1 1 −1 1 −1 −1 1 −1 1 1 −1 1 1 −1 1 1 1 −1 1 1 −1 1 −1 |
| | −1 1 −1 1 1 −1 1 1 1 −1 1 1 1 1 −1 −1 −1 −1 1 1 1 1 −1 1 1 1 −1 1 1 −1 1 −1 −1 1 |
| | −1 1 1 −1 1 1 1 −1 1 1 1 1 −1 −1 −1 −1 1 1 1 −1 1 −1 −1 −1 1 −1 −1 1 −1 1 1 −1 |
| | 1 −1 −1 1 −1 −1 −1 1 −1 −1 −1 −1 1 1 1 1 −1 −1 −1 −1 1 −1 −1 −1 1 −1 −1 1 −1 |
| | 1 1 −1 1 −1 −1 1 −1 −1 −1 1 −1 −1 −1 −1 1 1 1 1 −1 −1 −1 1 1 1 −1 −1 −1 −1 1 1 |
| | 1 1 −1 1 1 1 −1 1 1 −1 1 −1 −1 1 −1 1 1 −1 1 1 1 −1 1 −1 −1 −1 1 1 1 1 −1 −1 −1 |
| | −1 1 −1 −1 −1 1 −1 −1 1 −1 1 1 −1 1 −1 −1 1 −1 −1 −1 1 −1 −1 −1 −1 1 1 1 1 −1 |
| | −1 −1 −1 1 −1 −1 −1 1 −1 −1 1 −1 1 1 −1 1 −1 −1 1 −1 −1 −1 1 −1 1 1 1 −1 −1 |
| | −1 −1 1 1 1 1 −1 1 1 1 −1 1 1 −1 1 −1 −1 1 −1 1 1 −1 1 1 1 −1 1 1 −1 1 1 −1 1 −1 |
| | −1 1 −1 1 1 1 −1 1 1 1 −1 −1 −1 −1 1 1 1 1 −1 −1 −1 1 −1 −1 −1 −1 1 −1 −1 1 −1 |
| | 1 1 −1 1 −1 −1 −1 1 −1 −1 −1 1 1 1 1 −1 −1 −1 −1 1 1 1 −1 1 1 1 −1 1 −1 −1 1 |
| | −1 1 1 −1 1 −1 −1 −1 1 −1 −1 −1 1 1 1 1 −1 −1 −1 −1 1 1 1 −1 1 1 1 1 −1 1 1 −1 |
| | 1 −1 −1 1 −1 1 1 1 −1 1 1 1 −1 −1 −1 −1 1 1 1 1 −1 −1 −1 1 −1 −1 −1 1 1 1 −1 |
| | −1 −1 −1 1 −1 −1 −1 1 −1 −1 −1 1 −1 −1 1 −1 1 1 −1 1 1 1 −1 1 1 1 −1 1 −1 −1 |
| | −1 1 1 1 1 −1 1 1 1 −1 1 1 1 −1 1 1 −1 1 −1 −1 1 −1 −1 −1 1 −1 −1 −1 1 −1 −1 |
| | −1 −1 1 1 1 1 −1 1 1 1 −1 1 1 1 −1 1 1 −1 1 −1 −1 1 −1 −1 −1 1 −1 −1 −1 1 −1 1 |
| | 1 1 −1 −1 −1 −1 1 −1 −1 −1 1 −1 −1 −1 1 −1 −1 1 −1 1 1 −1 1 1 1 −1 1 1 1 −1 1 |
| | 1 −1 1 1 −1 1 −1 −1 −1 1 −1 −1 −1 1 −1 −1 −1 1 1 1 1 −1 −1 −1 1 −1 −1 −1 1 −1 |
| | −1 −1 −1 1 −1 −1 1 −1 1 1 1 −1 1 1 1 −1 1 1 1 −1 −1 −1 −1 1 1 1 −1 1 1 1 −1 1 1 |
| | 1 −1 1 −1 −1 1 −1 1 1 1 −1 1 1 1 −1 1 1 1 −1 −1 −1 −1 1 1 1 −1 1 1 1 −1 1 1 1 1 |
| | −1 1 1 −1 1 −1 −1 −1 1 −1 −1 −1 1 −1 −1 −1 1 1 1 1 −1 −1 −1 1 −1 −1 −1 1 −1 |
| | −1 −1 1 1 1 −1 1 1 1 −1 1 1 1 −1 −1 −1 −1 1 1 1 −1 1 1 1 −1 1 1 1 −1 1 −1 −1 1 |
| | −1 1 1 1 −1 1 1 1 −1 1 1 1 −1 −1 −1 −1 1 1 1 −1 1 1 1 −1 1 1 −1 1 −1 −1 1 −1 1 |
| | 1 1 −1 1 1 1 −1 1 1 1 −1 −1 −1 −1 1 1 1 −1 1 1 1 −1 1 1 1 −1 1 −1 −1 1 −1 1 1 1 |
| | −1 1 1 1 −1 1 1 1 −1 −1 −1 −1 1 1 1 −1 1 1 1 −1 1 1 1 −1 1 −1 −1 1 −1 −1 1 −1 |
| | −1 −1 1 −1 −1 −1 1 −1 −1 1 −1 1 1 −1 1 1 1 −1 1 1 1 −1 1 1 1 1 −1 −1 −1 −1 1 |
| | −1 −1 −1 1 −1 −1 −1 1 −1 −1 1 −1 1 1 −1 1 1 1 −1 1 1 1 −1 1 1 1 1 −1 −1 −1 −1 |
| | 1 −1 −1 −1 1 −1 −1 −1 1 −1 −1 1 −1 1 1 −1 1 1 1 −1 1 1 1 −1 1 1 1 1 −1 −1 −1 |
| | −1 1 −1 −1 −1 1 −1 −1 −1 1 −1 −1 1 −1 1 1 −1 1 1 1 −1 1 1 1 −1 1 1 1 1 −1 −1 |
| | −1 1 1 1 −1 1 1 1 −1 −1 −1 −1 1 1 1 1 −1 −1 −1 1 −1 −1 −1 1 −1 1 1 −1 1 −1 −1 |
| | 1 −1 1 1 1 −1 1 1 1 −1 −1 −1 −1 1 1 1 1 −1 −1 −1 1 −1 −1 −1 1 −1 1 1 −1 1 −1 |
| | −1 1 −1 1 1 1 −1 1 1 1 −1 −1 −1 −1 1 1 1 1 −1 −1 −1 1 −1 −1 −1 1 −1 1 1 −1 1 |
| | −1 −1 1 −1 1 1 1 −1 1 1 1 −1 −1 −1 −1 1 1 1 1 −1 −1 −1 1 −1 −1 −1 1 −1 1 1 −1 |
| | 1 −1 −1 1 −1 −1 1 −1 −1 −1 1 −1 −1 1 −1 1 1 −1 1 −1 −1 1 −1 −1 −1 1 −1 −1 −1 |
| | −1 1 1 1 1 −1 −1 −1 −1 1 −1 −1 −1 1 −1 −1 1 −1 1 1 −1 1 −1 −1 1 −1 −1 −1 1 −1 |
| | −1 −1 −1 1 1 1 1 −1 −1 −1 −1 1 −1 −1 −1 1 −1 −1 1 −1 1 1 −1 1 −1 −1 1 −1 −1 |
| | −1 1 −1 −1 −1 −1 1 1 1 1 −1 −1 −1 −1 1 −1 −1 −1 1 −1 −1 1 −1 1 1 −1 1 −1 −1 1 |
| | −1 −1 −1 1 −1 −1 −1 −1 1 1 1 1 −1 −1 −1 1 1 1 −1 −1 −1 −1 1 1 1 1 −1 1 1 1 −1 |
| | 1 1 −1 1 −1 −1 1 −1 1 1 −1 1 1 1 −1 1 −1 −1 −1 1 1 1 1 −1 −1 −1 −1 1 −1 −1 −1 |
| | 1 −1 −1 1 −1 1 1 −1 1 −1 −1 1 −1 −1 −1 1 −1 1 1 1 −1 −1 −1 −1 1 1 1 1 −1 1 1 1 |
| | −1 1 1 −1 1 −1 −1 1 −1 1 1 −1 1 1 1 −1 1 −1 −1 −1 1 1 1 1 −1 −1 −1 −1 1 −1 −1 |
| | −1 1 −1 −1 1 −1 1 1 −1 1 −1 −1 1 −1 −1 −1 1 −1 −1 1 −1 −1 1 −1 1 1 −1 1 −1 −1 |
| | −1 1 −1 −1 −1 1 1 1 1 −1 −1 −1 −1 1 1 1 −1 1 1 1 1 −1 1 1 −1 1 −1 −1 1 −1 1 1 1 |
| | −1 1 1 1 −1 −1 −1 −1 1 1 1 1 −1 −1 −1 1 −1 −1 −1 −1 1 −1 −1 1 −1 1 1 −1 1 −1 |
| | −1 −1 1 −1 −1 −1 1 1 1 1 −1 −1 −1 −1 1 1 1 −1 1 1 1 1 −1 1 1 −1 1 −1 −1 1 −1 1 |
| | 1 1 −1 1 1 1 −1 −1 −1 −1 1 1 1 1 −1 −1 −1 1 −1 −1 −1 1 1 1 −1 −1 −1 −1 1 −1 −1 |
| | −1 1 −1 −1 −1 1 −1 −1 1 −1 1 1 −1 1 1 1 −1 1 1 1 −1 1 −1 −1 −1 1 1 1 1 −1 1 1 1 |
| | −1 1 1 1 −1 1 1 −1 1 −1 −1 1 −1 −1 −1 1 −1 −1 −1 1 −1 1 1 1 −1 −1 −1 −1 1 −1 |
| | −1 −1 1 −1 −1 −1 1 −1 −1 1 −1 1 1 −1 1 1 1 −1 1 1 1 −1 1 −1 −1 −1 1 1 1 1 −1 1 |
| | 1 1 −1 1 1 1 −1 1 1 −1 1 −1 −1 1 −1 −1 −1 1 −1 −1 −1 1 −1 −1 1 −1 −1 1 −1 1 1 |
| | 1 −1 1 1 1 −1 1 1 1 −1 −1 −1 −1 1 1 1 −1 1 1 1 −1 1 1 1 1 −1 1 1 −1 1 −1 −1 −1 1 |
| | −1 −1 −1 1 −1 −1 −1 1 1 1 1 −1 −1 −1 1 −1 −1 −1 1 −1 −1 −1 −1 1 −1 −1 1 −1 1 |
| | 1 1 −1 1 1 1 −1 1 1 1 −1 −1 −1 −1 1 1 −1 1 1 1 −1 1 1 1 1 −1 1 1 −1 1 −1 −1 −1 |
| | 1 −1 −1 −1 1 −1 −1 −1 1 1 1 1 −1 −1 −1 1 −1 −1 −1 1 −1 −1 −1 |
| 13 | 1 1 1 1 1 −1 1 −1 1 1 1 1 1 −1 1 −1 1 1 1 1 1 −1 1 −1 1 1 1 1 1 −1 1 −1 1 1 1 1 −1 |
| | 1 −1 1 −1 −1 −1 −1 1 −1 1 −1 1 1 1 1 −1 1 −1 1 −1 −1 −1 −1 1 −1 1 −1 1 1 1 1 1 |
| | −1 1 −1 1 1 1 1 1 −1 1 −1 1 1 1 1 1 −1 1 −1 1 1 1 1 1 −1 1 −1 1 1 1 1 −1 1 −1 1 |
| | −1 −1 −1 −1 1 −1 1 −1 1 1 1 1 −1 1 −1 1 −1 −1 −1 −1 1 −1 1 −1 1 1 −1 −1 1 −1 |
| | −1 1 1 1 −1 −1 1 −1 −1 1 −1 −1 1 1 −1 1 1 −1 −1 −1 1 1 −1 1 1 −1 1 1 −1 −1 −1 |
| | 1 1 −1 −1 −1 1 1 1 −1 −1 1 −1 −1 1 1 1 −1 −1 1 1 1 1 −1 −1 1 1 −1 1 1 −1 −1 1 |
| | −1 −1 1 1 1 −1 −1 1 −1 −1 1 −1 −1 1 1 −1 1 1 −1 −1 −1 1 1 −1 1 1 −1 1 1 −1 −1 |
| | −1 1 1 −1 −1 −1 1 1 1 −1 −1 1 −1 −1 1 1 1 −1 −1 1 1 1 −1 −1 −1 1 1 −1 1 1 1 1 1 |
| | −1 1 −1 −1 −1 −1 −1 −1 1 −1 1 1 1 1 1 1 −1 1 −1 −1 −1 −1 −1 −1 1 −1 1 1 1 1 1 |
| | −1 1 −1 1 1 1 1 1 −1 1 −1 1 1 1 1 1 −1 1 −1 1 1 1 1 1 −1 1 −1 1 1 1 1 1 1 −1 1 −1 |
| | −1 −1 −1 −1 −1 1 −1 1 1 1 1 1 1 −1 1 −1 −1 −1 −1 −1 −1 1 −1 1 1 1 1 1 −1 1 −1 |
| | 1 1 1 1 1 −1 1 −1 1 1 1 1 1 −1 1 −1 1 1 1 1 1 −1 1 −1 1 1 1 −1 −1 1 −1 −1 1 −1 |
| | −1 1 1 −1 1 1 −1 −1 −1 1 1 −1 1 1 −1 1 1 −1 −1 1 −1 −1 1 1 1 −1 −1 −1 1 1 −1 1 |
| | 1 −1 −1 −1 1 1 −1 −1 −1 1 1 1 −1 −1 1 −1 −1 1 1 1 −1 −1 1 1 1 −1 −1 1 −1 −1 1 |
| | −1 −1 1 1 −1 1 1 −1 −1 −1 1 1 −1 1 1 −1 1 1 −1 −1 1 −1 −1 1 1 1 −1 −1 −1 1 1 |
| | −1 1 1 −1 −1 −1 1 1 −1 −1 −1 1 1 1 −1 −1 1 −1 −1 1 1 1 −1 −1 1 1 1 −1 −1 1 −1 |
| | −1 1 1 1 −1 −1 1 −1 −1 1 1 1 −1 −1 1 −1 −1 1 1 1 −1 −1 1 −1 −1 1 1 1 −1 −1 −1 |
| | 1 1 −1 −1 −1 1 1 1 −1 −1 1 1 1 −1 −1 −1 1 1 −1 −1 −1 1 1 1 −1 −1 1 −1 −1 1 1 |
| | −1 1 1 −1 −1 −1 1 1 −1 1 1 −1 −1 −1 1 1 −1 1 1 −1 −1 −1 1 1 −1 1 1 −1 −1 −1 1 |
| | 1 1 −1 −1 1 1 1 −1 −1 −1 1 1 −1 −1 −1 1 1 1 −1 −1 1 1 1 −1 −1 −1 1 1 −1 1 1 1 1 |
| | 1 −1 1 −1 1 1 1 1 1 −1 1 −1 −1 −1 −1 −1 −1 1 −1 1 −1 −1 −1 −1 −1 1 −1 1 1 1 1 |
| | 1 −1 1 −1 1 −1 −1 −1 −1 1 −1 1 −1 −1 −1 −1 −1 1 −1 1 −1 1 1 1 1 −1 1 −1 1 −1 |
| | −1 −1 −1 −1 1 −1 1 −1 −1 −1 −1 −1 1 −1 1 1 1 1 1 1 −1 1 −1 1 1 1 1 1 −1 1 −1 |
| | −1 −1 −1 −1 1 −1 1 −1 1 1 1 1 −1 1 −1 1 1 1 1 1 −1 1 −1 1 −1 −1 −1 −1 1 −1 1 |
| | −1 1 1 −1 −1 1 −1 −1 1 −1 −1 1 1 −1 1 1 −1 1 1 −1 −1 1 −1 −1 1 −1 −1 1 1 −1 1 |
| | 1 −1 1 1 −1 −1 −1 1 1 −1 1 1 −1 −1 −1 1 1 −1 1 1 −1 −1 −1 1 1 −1 1 1 −1 −1 −1 |
| | 1 1 −1 −1 −1 1 1 −1 1 1 −1 1 1 −1 −1 1 −1 −1 1 −1 −1 1 1 −1 1 1 −1 1 1 −1 −1 1 |
| | −1 −1 1 −1 −1 1 1 1 −1 −1 1 −1 −1 1 1 1 −1 −1 1 −1 −1 1 1 1 −1 −1 1 −1 −1 1 1 |
| | 1 −1 −1 1 1 1 1 1 1 −1 1 −1 −1 −1 −1 −1 −1 1 −1 1 −1 −1 −1 −1 −1 1 −1 1 1 1 1 |
| | 1 1 −1 1 −1 1 1 1 1 −1 1 −1 1 1 1 1 −1 1 −1 1 −1 −1 −1 −1 1 −1 1 −1 −1 −1 −1 |
| | −1 1 −1 1 −1 −1 −1 −1 −1 −1 1 −1 1 1 1 1 1 1 −1 1 −1 1 1 1 1 1 −1 1 −1 −1 −1 |
| | −1 −1 −1 1 −1 1 −1 −1 −1 −1 1 −1 1 −1 −1 −1 −1 −1 1 −1 1 −1 1 1 1 1 −1 1 −1 1 |
| | 1 1 1 1 −1 1 −1 1 1 1 1 1 1 −1 1 −1 1 1 1 1 1 −1 1 −1 −1 −1 −1 −1 −1 1 −1 1 −1 |
| | −1 −1 −1 −1 1 −1 1 1 1 1 1 −1 1 −1 1 −1 −1 −1 −1 1 −1 1 −1 −1 −1 −1 −1 1 −1 1 |
| | −1 1 1 1 1 −1 1 −1 1 1 1 1 1 1 −1 1 −1 1 1 1 1 1 −1 1 −1 −1 −1 −1 −1 −1 1 −1 1 |
| | −1 −1 −1 −1 −1 1 −1 1 1 1 1 1 −1 1 −1 1 −1 −1 −1 −1 1 −1 1 −1 −1 −1 −1 −1 1 |
| | −1 1 −1 1 1 1 1 −1 1 −1 1 1 1 −1 −1 1 −1 −1 1 1 1 −1 −1 1 −1 −1 1 1 1 −1 −1 1 |
| | −1 −1 1 1 1 −1 −1 1 −1 −1 1 1 1 −1 −1 −1 1 1 −1 −1 −1 1 1 1 −1 −1 1 1 1 −1 −1 |
| | −1 1 1 −1 −1 −1 1 1 1 −1 −1 1 1 1 −1 −1 1 −1 −1 1 1 1 −1 −1 1 −1 −1 1 1 1 −1 |
| | −1 1 −1 −1 1 1 1 −1 −1 1 −1 −1 1 1 1 −1 −1 −1 1 1 −1 −1 −1 1 1 1 −1 −1 1 1 1 |
| | −1 −1 −1 1 1 −1 −1 −1 1 1 1 −1 −1 1 −1 −1 −1 −1 −1 1 −1 1 1 1 1 1 1 −1 1 −1 1 |
| | 1 1 1 1 −1 1 −1 −1 −1 −1 −1 −1 1 −1 1 −1 −1 −1 −1 1 −1 1 −1 −1 −1 −1 −1 1 −1 |
| | 1 −1 1 1 1 1 −1 1 −1 1 1 1 1 1 −1 1 −1 1 −1 −1 −1 −1 −1 1 −1 1 1 1 1 1 1 −1 1 −1 |
| | 1 1 1 1 1 −1 1 −1 −1 −1 −1 −1 −1 1 −1 1 −1 −1 −1 −1 1 −1 1 −1 −1 −1 −1 −1 1 |
| | −1 1 −1 1 1 1 1 −1 1 −1 1 1 1 1 1 −1 1 −1 1 −1 −1 1 1 −1 1 1 −1 1 1 −1 −1 1 −1 |
| | −1 1 −1 −1 1 1 −1 1 1 −1 1 1 −1 −1 1 −1 −1 1 −1 −1 1 1 1 −1 −1 1 −1 −1 1 1 1 |
| | −1 −1 1 −1 −1 1 1 1 −1 −1 1 −1 −1 1 1 1 −1 −1 1 −1 −1 1 1 −1 1 1 −1 1 1 −1 −1 |
| | 1 −1 −1 1 −1 −1 1 1 −1 1 1 −1 1 1 −1 −1 1 −1 −1 1 −1 −1 1 1 1 −1 −1 1 −1 −1 1 |
| | 1 1 −1 −1 1 −1 −1 1 1 1 −1 −1 1 −1 −1 1 1 1 −1 −1 1 1 1 −1 −1 1 −1 −1 1 1 1 −1 |
| | −1 1 −1 −1 1 −1 −1 1 1 −1 1 1 −1 −1 −1 1 1 −1 1 1 −1 1 1 −1 −1 −1 1 1 −1 −1 −1 |
| | 1 1 1 −1 −1 1 −1 −1 1 1 1 −1 −1 1 1 1 −1 −1 −1 1 1 −1 −1 −1 1 1 −1 1 1 −1 −1 |
| | −1 1 1 −1 1 1 −1 1 1 −1 −1 1 −1 −1 1 1 1 −1 −1 1 −1 −1 1 −1 −1 1 1 1 −1 −1 1 1 |
| | 1 −1 −1 −1 1 1 −1 1 1 −1 −1 −1 1 1 −1 −1 −1 1 1 1 −1 −1 1 1 1 1 1 1 −1 1 −1 1 1 |
| | 1 1 1 −1 1 −1 1 1 1 1 1 −1 1 −1 1 1 1 1 1 −1 1 −1 1 1 1 1 −1 1 −1 1 −1 −1 −1 −1 |
| | 1 −1 1 −1 1 1 1 1 −1 1 −1 1 −1 −1 −1 −1 1 −1 1 −1 −1 −1 −1 −1 −1 1 −1 1 −1 −1 |
| | −1 −1 −1 1 −1 1 −1 −1 −1 −1 −1 1 −1 1 −1 −1 −1 −1 −1 1 −1 1 −1 −1 −1 −1 1 −1 |
| | 1 −1 1 1 1 1 −1 1 −1 1 −1 −1 −1 −1 1 −1 1 −1 1 1 1 1 −1 1 −1 1 −1 −1 1 1 −1 1 1 |
| | −1 1 1 −1 −1 1 −1 −1 1 1 1 −1 −1 1 −1 −1 1 −1 −1 1 1 −1 1 1 −1 −1 −1 1 1 1 −1 |
| | −1 1 −1 −1 1 1 1 −1 −1 1 1 1 −1 −1 −1 1 1 −1 1 1 −1 −1 −1 1 1 −1 1 1 −1 −1 1 |
| | −1 −1 1 −1 −1 1 1 −1 1 1 −1 −1 −1 1 1 −1 1 1 −1 1 1 −1 −1 1 −1 −1 1 1 1 −1 −1 |
| | −1 1 1 −1 1 1 −1 −1 −1 1 1 −1 −1 −1 1 1 1 −1 −1 1 −1 −1 1 1 1 −1 −1 1 −1 −1 −1 |
| | −1 −1 1 −1 1 1 1 1 1 1 −1 1 −1 −1 −1 −1 −1 −1 1 −1 1 1 1 1 1 1 −1 1 −1 −1 −1 |
| | −1 −1 1 −1 1 −1 −1 −1 −1 −1 1 −1 1 −1 −1 −1 −1 −1 1 −1 1 −1 −1 −1 −1 −1 1 −1 |
| | 1 −1 1 1 1 1 1 −1 1 −1 −1 −1 −1 −1 −1 1 −1 1 1 1 1 1 1 −1 1 −1 −1 −1 −1 −1 −1 |
| | 1 −1 1 1 1 1 1 −1 1 −1 1 1 1 1 1 −1 1 −1 1 1 1 1 1 −1 1 −1 1 1 1 1 1 −1 1 −1 1 1 1 |
| | 1 1 1 −1 1 −1 1 1 1 1 1 −1 1 −1 1 1 1 1 1 −1 1 −1 1 1 1 1 1 −1 1 −1 1 1 1 1 −1 1 |
| | −1 1 −1 −1 −1 −1 1 −1 1 −1 1 1 1 1 −1 1 −1 1 −1 −1 −1 −1 1 −1 1 −1 −1 −1 −1 |
| | −1 −1 1 −1 1 −1 −1 −1 −1 −1 1 −1 1 −1 −1 −1 −1 −1 1 −1 1 −1 −1 −1 −1 −1 1 −1 |
| | 1 −1 −1 −1 −1 1 −1 1 −1 1 1 1 1 −1 1 −1 1 −1 −1 −1 −1 1 −1 1 −1 1 1 1 1 −1 1 |
| | −1 1 1 1 −1 −1 1 −1 −1 1 1 1 −1 −1 1 −1 −1 1 −1 −1 1 1 −1 1 1 −1 −1 −1 1 1 −1 |
| | 1 1 −1 1 1 −1 −1 −1 1 1 −1 −1 −1 1 1 1 −1 −1 1 −1 −1 1 1 1 −1 −1 1 1 1 −1 −1 |
| | −1 1 1 −1 −1 −1 1 1 −1 1 1 −1 −1 −1 1 1 −1 1 1 −1 1 1 −1 −1 1 −1 −1 1 1 1 −1 |
| | −1 1 −1 −1 1 −1 −1 1 1 1 −1 −1 1 1 1 −1 −1 −1 1 1 −1 1 1 −1 −1 −1 1 1 −1 −1 −1 |
| | 1 1 1 −1 −1 1 1 1 1 1 1 −1 1 −1 −1 −1 −1 −1 −1 1 −1 1 1 1 1 1 1 −1 1 −1 −1 −1 |
| | −1 −1 −1 1 −1 1 1 1 1 1 −1 1 −1 1 1 1 1 1 −1 1 −1 1 1 1 1 1 −1 1 −1 1 1 1 1 1 −1 |
| | 1 −1 1 −1 −1 −1 −1 −1 1 −1 1 1 1 1 1 1 −1 1 −1 −1 −1 −1 −1 −1 1 −1 1 1 1 1 1 1 |
| | −1 1 −1 −1 −1 −1 −1 1 −1 1 −1 −1 −1 −1 −1 1 −1 1 −1 −1 −1 −1 −1 1 −1 1 −1 −1 |
| | −1 −1 −1 1 −1 1 −1 1 1 −1 −1 1 −1 −1 1 −1 −1 1 1 −1 1 1 −1 −1 −1 1 1 −1 1 1 −1 |
| | 1 1 −1 −1 1 −1 −1 1 1 1 −1 −1 −1 1 1 −1 1 1 −1 −1 −1 1 1 −1 −1 −1 1 1 1 −1 −1 |
| | 1 −1 −1 1 1 1 −1 −1 1 −1 −1 1 1 −1 1 1 −1 1 1 −1 −1 1 −1 −1 1 1 1 −1 −1 1 −1 |
| | −1 1 −1 −1 1 1 −1 1 1 −1 −1 −1 1 1 1 −1 −1 1 −1 −1 1 1 1 −1 −1 1 1 1 −1 −1 −1 |
| | 1 1 −1 1 1 −1 −1 −1 1 1 −1 1 1 −1 −1 1 −1 −1 1 1 1 −1 −1 1 −1 −1 1 1 1 −1 −1 1 |
| | −1 −1 1 1 1 −1 −1 1 −1 −1 1 1 1 −1 −1 −1 1 1 −1 −1 −1 1 1 1 −1 −1 1 1 1 −1 −1 |
| | −1 1 1 −1 −1 −1 1 1 1 −1 −1 1 1 1 −1 −1 1 −1 −1 1 1 1 −1 −1 1 −1 −1 1 1 1 −1 |
| | −1 1 −1 −1 1 1 1 −1 −1 1 −1 −1 1 1 1 −1 −1 −1 1 1 −1 −1 −1 1 1 1 −1 −1 1 1 1 |
| | −1 −1 −1 1 1 −1 −1 −1 1 1 1 −1 −1 1 1 1 1 1 1 −1 1 −1 1 1 1 1 1 −1 1 −1 −1 −1 |
| | −1 −1 −1 1 −1 1 −1 −1 −1 −1 −1 1 −1 1 1 1 1 1 −1 1 −1 1 −1 −1 −1 −1 1 −1 1 −1 |
| | −1 −1 −1 −1 1 −1 1 −1 1 1 1 1 −1 1 −1 1 1 1 1 1 1 −1 1 −1 1 1 1 1 1 −1 1 −1 −1 |
| | −1 −1 −1 −1 1 −1 1 −1 −1 −1 −1 −1 1 −1 1 1 1 1 1 −1 1 −1 1 −1 −1 −1 −1 1 −1 1 |
| | −1 −1 −1 −1 −1 1 −1 1 −1 1 1 1 1 −1 1 −1 1 1 1 −1 −1 1 −1 −1 1 −1 −1 1 1 −1 1 |
| | 1 −1 1 1 −1 −1 1 −1 −1 1 −1 −1 1 1 −1 1 1 −1 1 1 −1 −1 −1 1 1 −1 1 1 −1 −1 −1 |
| | 1 1 −1 1 1 −1 −1 −1 1 1 −1 1 1 −1 −1 −1 1 1 −1 1 1 −1 −1 1 −1 −1 1 −1 −1 1 1 |
| | −1 1 1 −1 1 1 −1 −1 1 −1 −1 1 −1 −1 1 1 −1 1 1 −1 1 1 −1 −1 −1 1 1 −1 1 1 −1 |
| | −1 −1 1 1 −1 1 1 −1 −1 −1 1 1 −1 1 1 −1 −1 −1 1 1 −1 1 1 1 1 1 −1 1 −1 −1 −1 |
| | −1 −1 −1 1 −1 1 −1 −1 −1 −1 −1 1 −1 1 1 1 1 1 1 −1 1 −1 1 1 1 1 −1 1 −1 1 1 1 1 |
| | 1 −1 1 −1 1 −1 −1 −1 −1 1 −1 1 −1 −1 −1 −1 1 −1 1 −1 1 1 1 1 1 −1 1 −1 −1 |
| | −1 −1 −1 −1 1 −1 1 −1 −1 −1 −1 −1 1 −1 1 1 1 1 1 1 −1 1 −1 1 1 1 1 −1 1 −1 1 1 |
| | 1 1 1 −1 1 −1 1 −1 −1 −1 −1 1 −1 1 −1 −1 −1 −1 −1 1 −1 1 −1 1 1 1 1 1 −1 1 −1 |
| | 1 1 1 1 1 −1 1 −1 −1 −1 −1 −1 −1 1 −1 1 −1 −1 −1 −1 −1 1 −1 1 1 1 1 1 −1 1 −1 |
| | 1 −1 −1 −1 −1 1 −1 1 −1 −1 −1 −1 −1 1 −1 1 −1 1 1 1 1 −1 1 −1 1 −1 −1 −1 −1 |
| | −1 1 −1 1 −1 −1 −1 −1 −1 1 −1 1 1 1 1 1 1 −1 1 −1 1 1 1 1 1 −1 1 −1 −1 −1 −1 |
| | −1 1 −1 1 −1 1 1 1 1 −1 1 −1 1 1 1 1 1 −1 1 −1 1 −1 −1 −1 −1 1 −1 1 −1 1 1 −1 |
| | −1 1 −1 −1 1 1 1 −1 −1 1 −1 −1 1 1 1 −1 −1 1 −1 −1 1 1 1 −1 −1 1 −1 −1 1 1 1 |
| | −1 −1 −1 1 1 −1 −1 −1 1 1 1 −1 −1 1 1 1 −1 −1 −1 1 1 −1 −1 −1 1 1 1 −1 −1 1 −1 |
| | −1 1 1 −1 1 1 −1 −1 −1 1 1 −1 1 1 −1 −1 −1 1 1 −1 1 1 −1 −1 −1 1 1 −1 1 1 −1 |
| | −1 −1 1 1 1 −1 −1 1 1 1 −1 −1 −1 1 1 −1 −1 −1 1 1 1 −1 −1 1 1 1 −1 −1 −1 1 1 |
| | −1 −1 −1 −1 −1 −1 1 −1 1 1 1 1 1 1 −1 1 −1 1 1 1 1 1 −1 1 −1 −1 −1 −1 −1 −1 1 |
| | −1 1 −1 −1 −1 −1 1 −1 1 −1 −1 −1 −1 −1 1 −1 1 −1 1 1 1 1 −1 1 −1 1 1 1 1 1 −1 |
| | 1 −1 1 1 1 1 1 1 −1 1 −1 −1 −1 −1 −1 −1 1 −1 1 −1 −1 −1 −1 −1 1 −1 1 1 1 1 1 1 |
| | −1 1 −1 1 1 1 1 −1 1 −1 1 1 1 1 1 −1 1 −1 1 −1 −1 −1 −1 1 −1 1 −1 −1 −1 −1 −1 |
| | 1 −1 1 −1 −1 −1 1 1 −1 1 1 −1 1 1 −1 −1 1 −1 −1 1 −1 −1 1 1 −1 1 1 −1 1 1 −1 |
| | −1 1 −1 −1 1 −1 −1 1 1 1 −1 −1 1 −1 −1 1 1 1 −1 −1 1 −1 −1 1 1 1 −1 −1 1 −1 −1 |
| | 1 1 1 −1 −1 1 1 1 −1 −1 1 −1 −1 1 −1 −1 1 1 −1 1 1 −1 1 1 −1 −1 1 −1 −1 1 −1 |
| | −1 1 1 −1 1 1 −1 1 1 −1 −1 −1 1 1 −1 1 1 −1 −1 −1 1 1 −1 1 1 −1 −1 −1 1 1 −1 1 |
| | 1 −1 −1 −1 1 1 −1 1 1 −1 −1 1 −1 −1 1 1 1 −1 −1 1 −1 −1 1 −1 −1 1 1 −1 1 1 −1 |
| | −1 −1 1 1 −1 1 1 −1 1 1 −1 −1 −1 1 1 −1 −1 −1 1 1 1 −1 −1 1 −1 −1 1 1 1 −1 −1 |
| | 1 1 1 −1 −1 −1 1 1 −1 1 1 −1 −1 1 −1 −1 1 1 1 −1 −1 1 −1 −1 1 −1 −1 1 1 −1 1 1 |
| | −1 −1 −1 1 1 −1 1 1 −1 1 1 −1 −1 −1 1 1 −1 −1 −1 1 1 1 −1 −1 1 −1 −1 1 1 1 −1 |
| | −1 1 1 1 −1 −1 −1 1 1 −1 1 1 1 1 1 −1 1 −1 1 1 1 1 1 −1 1 −1 1 1 1 1 1 −1 1 −1 1 |
| | 1 1 1 1 −1 1 −1 1 1 1 1 −1 1 −1 1 −1 −1 −1 −1 1 −1 1 −1 1 1 1 1 −1 1 −1 1 −1 −1 |
| | −1 −1 1 −1 1 −1 1 1 1 1 1 −1 1 −1 1 1 1 1 1 −1 1 −1 1 1 1 1 −1 1 −1 1 1 1 1 1 |
| | −1 1 −1 1 1 1 1 −1 1 −1 1 −1 −1 −1 −1 1 −1 1 −1 1 1 1 1 −1 1 −1 1 −1 −1 −1 −1 |
| | 1 −1 1 −1 −1 −1 1 1 −1 1 1 −1 1 1 −1 −1 1 −1 −1 1 1 1 −1 −1 1 −1 −1 1 −1 −1 1 |
| | 1 −1 1 1 −1 −1 −1 1 1 1 −1 −1 1 −1 −1 1 1 1 −1 −1 1 1 1 −1 −1 −1 1 1 −1 1 1 −1 |
| | −1 −1 1 1 −1 −1 −1 1 1 −1 1 1 −1 1 1 −1 −1 1 −1 −1 1 1 1 −1 −1 1 −1 −1 1 −1 −1 |
| | 1 1 −1 1 1 −1 −1 −1 1 1 1 −1 −1 1 −1 −1 1 1 1 −1 −1 1 1 1 −1 −1 −1 1 1 −1 1 1 |
| | −1 −1 −1 1 1 −1 −1 −1 −1 −1 −1 1 −1 1 1 1 1 1 1 −1 1 −1 −1 −1 −1 −1 −1 1 −1 1 |
| | 1 1 1 1 1 −1 1 −1 −1 −1 −1 −1 1 −1 1 −1 −1 −1 −1 −1 1 −1 1 −1 −1 −1 −1 −1 1 |
| | −1 1 −1 −1 −1 −1 −1 1 −1 1 −1 −1 −1 −1 −1 −1 1 −1 1 1 1 1 1 1 −1 1 −1 −1 −1 |
| | −1 −1 −1 1 −1 1 1 1 1 1 1 −1 1 −1 −1 −1 −1 −1 1 −1 1 −1 −1 −1 −1 −1 1 −1 1 −1 |
| | −1 −1 −1 −1 1 −1 1 −1 −1 −1 −1 −1 1 −1 1 −1 −1 −1 −1 −1 −1 1 −1 1 −1 −1 −1 |
| | −1 −1 1 −1 1 −1 −1 −1 −1 −1 1 −1 1 −1 −1 −1 −1 −1 1 −1 1 −1 −1 −1 −1 1 −1 1 |
| | −1 1 1 1 1 −1 1 −1 1 −1 −1 −1 −1 1 −1 1 −1 1 1 1 1 −1 1 −1 1 −1 −1 −1 −1 −1 1 |
| | −1 1 −1 −1 −1 −1 −1 1 −1 1 −1 −1 −1 −1 −1 1 −1 1 −1 −1 −1 −1 −1 1 −1 1 −1 −1 |
| | −1 −1 1 −1 1 −1 1 1 1 1 −1 1 −1 1 −1 −1 −1 −1 1 −1 1 −1 1 1 1 1 −1 1 −1 1 −1 |
| | −1 1 1 −1 1 1 −1 −1 −1 1 1 −1 1 1 −1 1 1 −1 −1 1 −1 −1 1 1 1 −1 −1 1 −1 −1 1 |
| | −1 −1 1 1 1 −1 −1 1 1 1 −1 −1 −1 1 1 −1 1 1 −1 −1 −1 1 1 −1 −1 −1 1 1 1 −1 −1 |
| | 1 −1 −1 1 1 −1 1 1 −1 −1 −1 1 1 −1 1 1 −1 1 1 −1 −1 1 −1 −1 1 1 1 −1 −1 1 −1 |
| | −1 1 −1 −1 1 1 1 −1 −1 1 1 1 −1 −1 −1 1 1 −1 1 1 −1 −1 −1 1 1 −1 −1 −1 1 1 1 |
| | −1 −1 1 −1 −1 −1 −1 −1 1 −1 1 1 1 1 1 1 −1 1 −1 −1 −1 −1 −1 −1 1 −1 1 1 1 1 1 |
| | 1 −1 1 −1 −1 −1 −1 −1 1 −1 1 −1 −1 −1 −1 −1 1 −1 1 −1 −1 −1 −1 −1 1 −1 1 −1 |
| | −1 −1 −1 −1 1 −1 1 −1 −1 −1 −1 −1 −1 1 −1 1 1 1 1 1 1 −1 1 −1 −1 −1 −1 −1 −1 |
| | 1 −1 1 1 1 1 1 1 −1 1 −1 −1 −1 −1 −1 1 −1 1 −1 −1 −1 −1 −1 1 −1 1 −1 −1 −1 −1 |
| | −1 1 −1 1 −1 −1 −1 −1 −1 1 −1 1 −1 −1 −1 1 1 −1 1 1 −1 1 1 −1 −1 1 −1 −1 1 1 1 |
| | −1 −1 1 −1 −1 1 −1 −1 1 1 −1 1 1 −1 −1 −1 1 1 1 −1 −1 1 −1 −1 1 1 1 −1 −1 1 1 |
| | 1 −1 −1 −1 1 1 −1 1 1 −1 −1 −1 1 1 −1 −1 −1 1 1 −1 1 1 −1 1 1 −1 −1 1 −1 −1 1 |
| | 1 1 −1 −1 1 −1 −1 1 −1 −1 1 1 −1 1 1 −1 −1 −1 1 1 1 −1 −1 1 −1 −1 1 1 1 −1 −1 |
| | 1 1 1 −1 −1 −1 1 1 −1 1 1 −1 −1 −1 1 1 −1 −1 −1 1 1 −1 1 1 −1 −1 −1 1 1 −1 1 1 |
| | −1 −1 −1 1 1 −1 1 1 −1 −1 −1 1 1 −1 1 1 −1 −1 −1 1 1 1 −1 −1 1 1 1 −1 −1 −1 1 |
| | 1 −1 −1 −1 1 1 1 −1 −1 1 1 1 −1 −1 −1 1 1 −1 1 1 −1 −1 1 −1 −1 1 1 1 −1 −1 1 |
| | −1 −1 1 1 1 −1 −1 1 −1 −1 1 1 1 −1 −1 1 −1 −1 1 1 1 −1 −1 −1 1 1 −1 −1 −1 1 1 |
| | 1 −1 −1 1 1 1 −1 −1 −1 1 1 −1 −1 −1 1 1 1 −1 −1 1 −1 −1 −1 −1 −1 1 −1 1 −1 −1 |
| | −1 −1 −1 1 −1 1 1 1 1 1 1 −1 1 −1 1 1 1 1 1 −1 1 −1 −1 −1 −1 −1 1 −1 1 −1 1 1 1 |
| | 1 −1 1 −1 1 1 1 1 1 −1 1 −1 1 −1 −1 −1 −1 1 −1 1 −1 1 1 1 1 1 −1 1 −1 1 1 1 1 1 |
| | −1 1 −1 −1 −1 −1 −1 −1 1 −1 1 −1 −1 −1 −1 −1 1 −1 1 1 1 1 1 −1 1 −1 1 −1 −1 |
| | −1 −1 1 −1 1 −1 −1 −1 −1 −1 1 −1 1 −1 1 1 1 1 −1 1 −1 1 −1 −1 1 1 −1 1 1 −1 1 |
| | 1 −1 −1 1 −1 −1 1 −1 −1 1 1 −1 1 1 −1 1 1 −1 −1 1 −1 −1 1 −1 −1 1 1 1 −1 −1 1 |
| | −1 −1 1 1 1 −1 −1 1 −1 −1 1 1 1 −1 −1 1 −1 −1 1 1 1 −1 −1 1 1 1 −1 −1 1 −1 −1 |
| | 1 −1 −1 1 1 −1 1 1 −1 1 1 −1 −1 1 −1 −1 1 −1 −1 1 1 −1 1 1 −1 1 1 −1 −1 −1 1 1 |
| | −1 1 1 −1 −1 −1 1 1 −1 1 1 −1 −1 −1 1 1 −1 1 1 −1 −1 −1 1 1 −1 −1 −1 −1 −1 −1 |
| | 1 −1 1 1 1 1 1 1 −1 1 −1 1 1 1 1 1 −1 1 −1 −1 −1 −1 −1 −1 1 −1 1 −1 −1 −1 −1 1 |
| | −1 1 −1 −1 −1 −1 −1 1 −1 1 −1 1 1 1 1 −1 1 −1 1 1 1 1 1 −1 1 −1 1 1 1 1 1 1 −1 1 |
| | −1 −1 −1 −1 −1 −1 1 −1 1 −1 −1 −1 −1 −1 1 −1 1 1 1 1 1 1 −1 1 −1 1 1 1 1 −1 1 |
| | −1 1 1 1 1 1 −1 1 −1 1 −1 −1 −1 −1 1 −1 1 −1 −1 −1 −1 −1 1 −1 1 −1 −1 −1 −1 |
| | −1 −1 1 −1 1 −1 −1 −1 −1 −1 1 −1 1 1 1 1 1 1 −1 1 −1 1 1 1 1 1 −1 1 −1 −1 −1 |
| | −1 −1 1 −1 1 −1 1 1 1 1 −1 1 −1 1 1 1 1 1 −1 1 −1 1 −1 −1 −1 −1 1 −1 1 −1 −1 |
| | −1 −1 −1 −1 1 −1 1 −1 −1 −1 −1 −1 1 −1 1 1 1 1 1 1 −1 1 −1 1 1 1 1 −1 1 −1 |
| | −1 −1 −1 −1 1 −1 1 −1 1 1 1 1 −1 1 −1 1 1 1 1 1 −1 1 −1 1 −1 −1 −1 −1 1 −1 1 |
| | −1 −1 −1 1 1 −1 1 1 −1 −1 −1 1 1 −1 1 1 −1 −1 −1 1 1 −1 1 1 −1 −1 −1 1 1 −1 1 |
| | 1 −1 −1 −1 1 1 1 −1 −1 1 1 1 −1 −1 −1 1 1 −1 −1 −1 1 1 1 −1 −1 1 1 1 −1 −1 −1 |
| | 1 1 −1 −1 −1 1 1 −1 1 1 −1 −1 −1 1 1 −1 1 1 −1 −1 −1 1 1 −1 1 1 −1 −1 −1 1 1 |
| | −1 1 1 −1 −1 −1 1 1 1 −1 −1 1 1 1 −1 −1 −1 1 1 −1 −1 −1 1 1 1 −1 −1 1 1 1 −1 |
| | −1 −1 1 1 −1 1 1 1 1 1 −1 1 −1 −1 −1 −1 −1 −1 1 −1 1 −1 −1 −1 −1 −1 1 −1 1 1 1 |
| | 1 1 1 −1 1 −1 1 1 1 1 −1 1 −1 1 1 1 1 1 −1 1 −1 1 −1 −1 −1 −1 1 −1 1 −1 −1 −1 |
| | −1 −1 1 −1 1 −1 1 1 1 1 1 −1 1 −1 −1 −1 −1 −1 −1 1 −1 1 −1 −1 −1 −1 −1 1 −1 1 |
| | 1 1 1 1 1 −1 1 −1 1 1 1 1 −1 1 −1 1 1 1 1 1 −1 1 −1 1 −1 −1 −1 −1 1 −1 1 −1 −1 |
| | −1 −1 −1 1 −1 1 −1 1 1 −1 −1 1 −1 −1 1 −1 −1 1 1 −1 1 1 −1 1 1 −1 −1 1 −1 −1 1 |
| | −1 −1 1 1 −1 1 1 −1 1 1 −1 −1 −1 1 1 −1 1 1 −1 −1 −1 1 1 −1 1 1 −1 −1 −1 1 1 |
| | −1 1 1 −1 −1 −1 1 1 −1 1 1 −1 −1 1 −1 −1 1 −1 −1 1 1 −1 1 1 −1 1 1 −1 −1 1 −1 |
| | −1 1 −1 −1 1 1 −1 1 1 −1 1 1 −1 −1 −1 1 1 −1 1 1 −1 −1 −1 1 1 −1 1 1 −1 −1 −1 |
| | 1 1 −1 1 1 −1 −1 −1 1 1 −1 −1 −1 1 1 −1 1 1 −1 −1 −1 1 1 −1 1 1 −1 1 1 −1 −1 1 |
| | −1 −1 1 1 1 −1 −1 1 −1 −1 1 −1 −1 1 1 1 −1 −1 1 1 1 −1 −1 −1 1 1 −1 1 1 −1 −1 |
| | −1 1 1 −1 −1 −1 1 1 1 −1 −1 1 1 1 −1 −1 1 −1 −1 1 1 1 −1 −1 1 −1 −1 1 −1 −1 1 |
| | 1 −1 1 1 −1 −1 −1 1 1 −1 1 1 −1 1 1 −1 −1 −1 1 1 −1 −1 −1 1 1 1 −1 −1 1 −1 −1 |
| | 1 1 1 −1 −1 1 1 1 −1 −1 −1 1 1 −1 −1 −1 −1 −1 −1 1 −1 1 −1 −1 −1 −1 −1 1 −1 1 |
| | −1 −1 −1 −1 −1 1 −1 1 −1 −1 −1 −1 −1 1 −1 1 −1 −1 −1 −1 1 −1 1 −1 1 1 1 1 −1 |
| | 1 −1 1 −1 −1 −1 −1 1 −1 1 −1 1 1 1 1 −1 1 −1 1 1 1 1 1 1 −1 1 −1 1 1 1 1 1 −1 1 |
| | −1 1 1 1 1 1 −1 1 −1 1 1 1 1 1 −1 1 −1 1 1 1 1 −1 1 −1 1 −1 −1 −1 −1 1 −1 1 −1 1 |
| | 1 1 1 −1 1 −1 1 −1 −1 −1 −1 1 −1 1 −1 1 1 −1 −1 1 −1 −1 1 −1 −1 1 1 −1 1 1 −1 |
| | −1 −1 1 1 −1 1 1 −1 1 1 −1 −1 1 −1 −1 1 1 1 −1 −1 −1 1 1 −1 1 1 −1 −1 −1 1 1 |
| | −1 −1 −1 1 1 1 −1 −1 1 −1 −1 1 1 1 −1 −1 1 −1 −1 1 1 −1 1 1 −1 1 1 −1 −1 1 −1 |
| | −1 1 1 1 −1 −1 1 −1 −1 1 −1 −1 1 1 −1 1 1 −1 −1 −1 1 1 1 −1 −1 1 −1 −1 1 1 1 |
| | −1 −1 1 1 1 −1 −1 −1 1 1 −1 1 1 −1 −1 −1 1 1 −1 1 1 1 1 1 −1 1 −1 −1 −1 −1 −1 |
| | −1 1 −1 1 1 1 1 1 1 −1 1 −1 −1 −1 −1 −1 −1 1 −1 1 1 1 1 1 −1 1 −1 1 1 1 1 1 −1 1 |
| | −1 1 1 1 1 −1 1 −1 1 1 1 1 1 −1 1 −1 1 −1 −1 −1 −1 −1 1 −1 1 1 1 1 1 −1 1 −1 |
| | −1 −1 −1 −1 −1 1 −1 1 1 1 1 1 1 −1 1 −1 −1 −1 −1 −1 1 −1 1 −1 −1 −1 −1 −1 1 |
| | −1 1 −1 −1 −1 −1 −1 1 −1 1 −1 −1 −1 −1 −1 1 −1 1 −1 1 1 1 1 1 −1 1 −1 1 1 1 1 |
| | 1 −1 1 −1 1 1 1 1 1 −1 1 −1 1 1 1 1 1 −1 1 −1 1 1 1 1 −1 1 −1 1 −1 −1 −1 −1 1 −1 |
| | 1 −1 1 1 1 1 −1 1 −1 1 −1 −1 −1 −1 1 −1 1 −1 −1 −1 −1 −1 −1 1 −1 1 −1 −1 −1 |
| | −1 −1 1 −1 1 −1 −1 −1 −1 −1 1 −1 1 −1 −1 −1 −1 −1 1 −1 1 −1 −1 −1 −1 1 −1 1 |
| | −1 1 1 1 1 −1 1 −1 1 −1 −1 −1 −1 1 −1 1 −1 1 1 1 1 −1 1 −1 1 1 1 −1 −1 1 −1 −1 |
| | 1 1 1 −1 −1 1 −1 −1 1 −1 −1 1 1 −1 1 1 −1 −1 −1 1 1 −1 1 1 −1 1 1 −1 −1 −1 1 1 |
| | −1 −1 −1 1 1 1 −1 −1 1 −1 −1 1 1 1 −1 −1 1 1 1 −1 −1 −1 1 1 −1 −1 −1 1 1 −1 1 |
| | 1 −1 −1 −1 1 1 −1 1 1 −1 1 1 −1 −1 1 −1 −1 1 1 1 −1 −1 1 −1 −1 1 −1 −1 1 1 1 |
| | −1 −1 1 1 1 −1 −1 −1 1 1 −1 1 1 −1 −1 −1 1 1 −1 −1 −1 1 1 1 −1 −1 1 1 1 1 1 1 |
| | −1 1 −1 −1 −1 −1 −1 −1 1 −1 1 1 1 1 1 1 −1 1 −1 −1 −1 −1 −1 −1 1 −1 1 1 1 1 1 |
| | −1 1 −1 1 1 1 1 1 −1 1 −1 1 1 1 1 1 −1 1 −1 1 1 1 1 1 −1 1 −1 1 −1 −1 −1 −1 −1 1 |
| | −1 1 1 1 1 1 1 −1 1 −1 −1 −1 −1 −1 −1 1 −1 1 1 1 1 1 1 −1 1 −1 −1 −1 −1 −1 1 |
| | −1 1 −1 −1 −1 −1 −1 1 −1 1 −1 −1 −1 −1 −1 1 −1 1 −1 −1 −1 −1 −1 1 −1 1 −1 1 |
| | 1 −1 −1 1 −1 −1 1 −1 −1 1 1 −1 1 1 −1 −1 −1 1 1 −1 1 1 −1 1 1 −1 −1 1 −1 −1 1 |
| | 1 1 −1 −1 −1 1 1 −1 1 1 −1 −1 −1 1 1 −1 −1 −1 1 1 1 −1 −1 1 −1 −1 1 1 1 −1 −1 |
| | 1 −1 −1 1 1 −1 1 1 −1 1 1 −1 −1 1 −1 −1 1 1 1 −1 −1 1 −1 −1 1 −1 −1 1 1 −1 1 1 |
| | −1 −1 −1 1 1 1 −1 −1 1 −1 −1 1 1 1 −1 −1 1 1 1 −1 −1 −1 1 1 −1 1 1 −1 −1 −1 1 |
| | 1 −1 1 1 −1 −1 1 −1 −1 1 1 1 −1 −1 1 −1 −1 1 1 1 −1 −1 1 −1 −1 1 1 1 −1 −1 1 |
| | −1 −1 1 1 1 −1 −1 −1 1 1 −1 −1 −1 1 1 1 −1 −1 1 1 1 −1 −1 −1 1 1 −1 −1 −1 1 1 |
| | 1 −1 −1 1 1 1 −1 −1 1 −1 −1 1 1 1 −1 −1 1 −1 −1 1 1 1 −1 −1 1 −1 −1 1 1 1 −1 |
| | −1 1 −1 −1 1 1 1 −1 −1 −1 1 1 −1 −1 −1 1 1 1 −1 −1 1 1 1 −1 −1 −1 1 1 −1 −1 −1 |
| | 1 1 1 −1 −1 1 1 1 1 1 1 −1 1 −1 1 1 1 1 1 −1 1 −1 −1 −1 −1 −1 −1 1 −1 1 −1 −1 |
| | −1 −1 −1 1 −1 1 1 1 1 1 −1 1 −1 1 −1 −1 −1 −1 1 −1 1 −1 −1 −1 −1 −1 1 −1 1 −1 |
| | 1 1 1 1 −1 1 −1 1 1 1 1 1 1 −1 1 −1 1 1 1 1 1 −1 1 −1 −1 −1 −1 −1 −1 1 −1 1 −1 |
| | −1 −1 −1 −1 1 −1 1 1 1 1 1 −1 1 −1 1 −1 −1 −1 −1 1 −1 1 −1 −1 −1 −1 −1 1 −1 1 |
| | −1 1 1 1 1 −1 1 −1 1 1 1 −1 −1 1 −1 −1 1 −1 −1 1 1 −1 1 1 −1 1 1 −1 −1 1 −1 −1 |
| | 1 −1 −1 1 1 −1 1 1 −1 1 1 −1 −1 −1 1 1 −1 1 1 −1 −1 −1 1 1 −1 1 1 −1 −1 −1 1 1 |
| | −1 1 1 −1 −1 −1 1 1 −1 1 1 −1 −1 1 −1 −1 1 −1 −1 1 1 −1 1 1 −1 1 1 −1 −1 1 −1 |
| | −1 1 −1 −1 1 1 −1 1 1 −1 1 1 −1 −1 −1 1 1 −1 1 1 −1 −1 −1 1 1 −1 1 1 −1 −1 −1 |
| | 1 1 −1 1 1 −1 −1 −1 1 1 −1 1 1 1 1 1 −1 1 −1 −1 −1 −1 −1 −1 1 −1 1 −1 −1 −1 −1 |
| | −1 1 −1 1 1 1 1 1 1 −1 1 −1 1 1 1 1 −1 1 −1 1 1 1 1 1 −1 1 −1 1 −1 −1 −1 −1 1 −1 |
| | 1 −1 −1 −1 −1 −1 1 −1 1 −1 1 1 1 1 1 −1 1 −1 −1 −1 −1 −1 −1 1 −1 1 −1 −1 −1 |
| | −1 −1 1 −1 1 1 1 1 1 1 −1 1 −1 1 1 1 1 −1 1 −1 1 1 1 1 1 −1 1 −1 1 −1 −1 −1 −1 1 |
| | −1 1 −1 −1 −1 −1 −1 1 −1 1 −1 1 1 1 1 1 −1 1 −1 1 1 1 1 1 −1 1 −1 −1 −1 −1 −1 |
| | −1 1 −1 1 −1 −1 −1 −1 −1 1 −1 1 1 1 1 1 −1 1 −1 1 −1 −1 −1 −1 1 −1 1 −1 −1 −1 |
| | −1 −1 1 −1 1 −1 1 1 1 1 −1 1 −1 1 −1 −1 −1 −1 −1 1 −1 1 −1 −1 −1 −1 −1 1 −1 1 |
| | 1 1 1 1 1 −1 1 −1 1 1 1 1 1 −1 1 −1 −1 −1 −1 −1 1 −1 1 −1 1 1 1 1 −1 1 −1 1 1 1 |
| | 1 1 −1 1 −1 1 −1 −1 −1 −1 1 −1 1 −1 1 1 −1 −1 1 −1 −1 1 1 1 −1 −1 1 −1 −1 1 1 |
| | 1 −1 −1 1 −1 −1 1 1 1 −1 −1 1 −1 −1 1 1 1 −1 −1 −1 1 1 −1 −1 −1 1 1 1 −1 −1 1 |
| | 1 1 −1 −1 −1 1 1 −1 −1 −1 1 1 1 −1 −1 1 −1 −1 1 1 −1 1 1 −1 −1 −1 1 1 −1 1 1 |
| | −1 −1 −1 1 1 −1 1 1 −1 −1 −1 1 1 −1 1 1 −1 −1 −1 1 1 1 −1 −1 1 1 1 −1 −1 −1 1 |
| | 1 −1 −1 −1 1 1 1 −1 −1 1 1 1 −1 −1 −1 1 1 −1 −1 −1 −1 −1 −1 1 −1 1 1 1 1 1 1 |
| | −1 1 −1 1 1 1 1 1 −1 1 −1 −1 −1 −1 −1 −1 1 −1 1 −1 −1 −1 −1 1 −1 1 −1 −1 −1 |
| | −1 −1 1 −1 1 −1 1 1 1 1 −1 1 −1 1 1 1 1 1 −1 1 −1 1 1 1 1 1 1 −1 1 −1 −1 −1 −1 |
| | −1 −1 1 −1 1 −1 −1 −1 −1 −1 1 −1 1 1 1 1 1 1 −1 1 −1 1 1 1 1 −1 1 −1 1 1 1 1 1 |
| | −1 1 −1 1 −1 −1 −1 −1 1 −1 1 −1 −1 −1 −1 −1 1 −1 1 −1 −1 −1 1 1 −1 1 1 −1 1 1 |
| | −1 −1 1 −1 −1 1 −1 −1 1 1 −1 1 1 −1 1 1 −1 −1 1 −1 −1 1 −1 −1 1 1 1 −1 −1 1 −1 |
| | −1 1 1 1 −1 −1 1 −1 −1 1 1 1 −1 −1 1 −1 −1 1 1 1 −1 −1 1 1 1 −1 −1 1 −1 −1 1 |
| | −1 −1 1 1 −1 1 1 −1 1 1 −1 −1 1 −1 −1 1 −1 −1 1 1 −1 1 1 −1 1 1 −1 −1 −1 1 1 |
| | −1 1 1 −1 −1 −1 1 1 −1 1 1 −1 −1 −1 1 1 −1 1 1 −1 −1 −1 1 1 −1 1 1 −1 −1 1 −1 |
| | −1 1 1 1 −1 −1 1 −1 −1 1 −1 −1 1 1 −1 1 1 −1 −1 −1 1 1 −1 1 1 −1 1 1 −1 −1 −1 |
| | 1 1 −1 −1 −1 1 1 1 −1 −1 1 −1 −1 1 1 1 −1 −1 1 1 1 −1 −1 −1 1 1 −1 1 1 −1 −1 1 |
| | −1 −1 1 1 1 −1 −1 1 −1 −1 1 −1 −1 1 1 −1 1 1 −1 −1 −1 1 1 −1 1 1 −1 1 1 −1 −1 |
| | −1 1 1 −1 −1 −1 1 1 1 −1 −1 1 −1 −1 1 1 1 −1 −1 1 1 1 −1 −1 −1 1 1 −1 1 1 1 1 1 |
| | −1 1 −1 1 1 1 1 1 −1 1 −1 1 1 1 1 1 −1 1 −1 1 1 1 1 1 −1 1 −1 1 1 1 1 −1 1 −1 1 |
| | −1 −1 −1 −1 1 −1 1 −1 1 1 1 1 −1 1 −1 1 −1 −1 −1 −1 1 −1 1 −1 1 1 1 1 1 −1 1 |
| | −1 1 1 1 1 1 −1 1 −1 1 1 1 1 1 −1 1 −1 1 1 1 1 1 −1 1 −1 1 1 1 1 −1 1 −1 1 −1 −1 |
| | −1 −1 1 −1 1 −1 1 1 1 1 −1 1 −1 1 −1 −1 −1 −1 1 −1 1 −1 −1 −1 1 1 −1 1 1 −1 1 |
| | 1 −1 −1 1 −1 −1 1 1 1 −1 −1 1 −1 −1 1 −1 −1 1 1 −1 1 1 −1 −1 −1 1 1 1 −1 −1 1 |
| | −1 −1 1 1 1 −1 −1 1 1 1 −1 −1 −1 1 1 −1 1 1 −1 −1 −1 1 1 −1 −1 −1 1 1 −1 1 1 |
| | −1 1 1 −1 −1 1 −1 −1 1 1 1 −1 −1 1 −1 −1 1 −1 −1 1 1 −1 1 1 −1 −1 −1 1 1 1 −1 |
| | −1 1 −1 −1 1 1 1 −1 −1 1 1 1 −1 −1 −1 1 1 −1 1 1 −1 −1 −1 1 1 −1 −1 −1 −1 −1 |
| | −1 1 −1 1 1 1 1 1 1 −1 1 −1 −1 −1 −1 −1 −1 1 −1 1 1 1 1 1 1 −1 1 −1 −1 −1 −1 |
| | −1 1 −1 1 −1 −1 −1 −1 −1 1 −1 1 −1 −1 −1 −1 −1 1 −1 1 −1 −1 −1 −1 −1 1 −1 1 |
| | −1 −1 −1 −1 −1 −1 1 −1 1 1 1 1 1 1 −1 1 −1 −1 −1 −1 −1 −1 1 −1 1 1 1 1 1 1 −1 |
| | 1 −1 −1 −1 −1 −1 1 −1 1 −1 −1 −1 −1 −1 1 −1 1 −1 −1 −1 −1 −1 1 −1 1 −1 −1 −1 |
| | −1 −1 1 −1 1 −1 |
| 14 | ′1 1 1 1 1 1 −1 −1 1 −1 1 −1 1 −1 −1 1 1 1 1 1 1 1 −1 −1 1 −1 1 −1 1 −1 −1 1 1 1 |
| | 1 1 1 1 −1 −1 1 −1 1 −1 1 −1 −1 1 −1 −1 −1 −1 −1 −1 1 1 −1 1 −1 1 −1 1 1 −1 1 |
| | 1 1 1 1 1 −1 −1 1 −1 1 −1 1 −1 −1 1 1 1 1 1 1 1 −1 −1 1 −1 1 −1 1 −1 −1 1 1 1 1 |
| | 1 1 1 −1 −1 1 −1 1 −1 1 −1 −1 1 −1 −1 −1 −1 −1 −1 1 1 −1 1 −1 1 −1 1 1 −1 1 −1 |
| | 1 −1 −1 1 1 −1 1 1 1 1 −1 −1 1 1 1 −1 1 −1 −1 1 1 −1 1 1 1 1 −1 1 1 1 1 −1 1 −1 |
| | −1 1 1 −1 1 1 1 1 −1 −1 1 1 −1 1 −1 1 1 −1 −1 1 −1 −1 −1 −1 1 1 −1 −1 1 −1 1 |
| | −1 −1 1 1 −1 1 1 1 1 −1 −1 1 1 1 −1 1 −1 −1 1 1 −1 1 1 1 1 −1 −1 1 1 1 −1 1 −1 |
| | −1 1 1 −1 1 1 1 1 −1 −1 1 1 −1 1 −1 1 1 −1 −1 1 −1 −1 −1 −1 1 1 −1 −1 1 1 1 1 1 |
| | 1 −1 −1 1 −1 1 −1 1 −1 −1 1 −1 −1 −1 −1 −1 −1 1 1 −1 1 −1 1 −1 1 1 −1 1 1 1 1 |
| | 1 1 −1 −1 1 −1 1 −1 1 −1 −1 1 1 1 1 1 1 1 −1 −1 1 −1 1 −1 1 −1 −1 1 −1 −1 −1 |
| | −1 −1 −1 1 1 −1 1 −1 1 −1 1 1 −1 1 1 1 1 1 1 −1 −1 1 −1 1 −1 1 −1 −1 1 −1 −1 |
| | −1 −1 −1 −1 1 1 −1 1 −1 1 −1 1 1 −1 −1 −1 −1 −1 −1 −1 1 1 −1 1 −1 1 −1 1 1 −1 |
| | 1 −1 1 −1 −1 1 1 −1 1 1 1 1 −1 −1 1 1 −1 1 −1 1 1 −1 −1 1 −1 −1 −1 −1 1 1 −1 |
| | −1 1 −1 1 −1 −1 1 1 −1 1 1 1 1 −1 −1 1 1 1 −1 1 −1 −1 1 1 −1 1 1 1 1 −1 −1 1 1 |
| | −1 1 −1 1 1 −1 −1 1 −1 −1 −1 −1 1 1 −1 −1 1 −1 1 −1 −1 1 1 −1 1 1 1 1 −1 −1 1 |
| | 1 −1 1 −1 1 1 −1 −1 1 −1 −1 −1 −1 1 1 −1 −1 −1 1 −1 1 1 −1 −1 1 −1 −1 −1 −1 1 |
| | 1 −1 −1 1 1 1 1 1 1 −1 −1 −1 1 −1 1 −1 1 1 −1 1 1 1 1 1 1 −1 −1 −1 1 −1 1 −1 1 1 |
| | −1 1 1 1 1 1 1 −1 −1 −1 1 −1 1 −1 1 1 −1 −1 −1 −1 −1 −1 1 1 1 1 −1 1 −1 1 −1 |
| | −1 1 1 1 1 1 1 1 −1 −1 −1 1 −1 1 −1 1 1 −1 1 1 1 1 1 1 −1 −1 −1 1 −1 1 −1 1 1 −1 |
| | 1 1 1 1 1 1 −1 −1 −1 1 −1 1 −1 1 1 −1 −1 −1 −1 −1 −1 −1 1 1 1 −1 1 −1 1 −1 −1 |
| | 1 1 −1 1 −1 −1 1 1 −1 −1 −1 −1 −1 1 1 −1 −1 1 −1 1 −1 −1 1 1 −1 −1 −1 −1 −1 1 |
| | 1 −1 −1 1 −1 1 −1 −1 1 1 −1 −1 −1 −1 −1 1 1 −1 −1 −1 1 −1 1 1 −1 −1 1 1 1 1 1 |
| | −1 −1 1 1 1 −1 1 −1 −1 1 1 −1 −1 −1 −1 −1 1 1 −1 −1 1 −1 1 −1 −1 1 1 −1 −1 −1 |
| | −1 −1 1 1 −1 −1 1 −1 1 −1 −1 1 1 −1 −1 −1 −1 −1 1 1 −1 −1 −1 1 −1 1 1 −1 −1 1 |
| | 1 1 1 1 −1 −1 1 1 1 1 1 1 1 1 −1 −1 −1 1 −1 1 −1 1 1 −1 −1 −1 −1 −1 −1 −1 1 1 1 |
| | −1 1 −1 1 −1 −1 1 1 1 1 1 1 1 −1 −1 −1 1 −1 1 −1 1 1 −1 1 1 1 1 1 1 −1 −1 −1 1 |
| | −1 1 −1 1 1 −1 −1 −1 −1 −1 −1 −1 1 1 1 −1 1 −1 1 −1 −1 1 1 1 1 1 1 1 −1 −1 −1 |
| | 1 −1 1 −1 1 1 −1 −1 −1 −1 −1 −1 −1 1 1 1 −1 1 −1 1 −1 −1 1 −1 −1 −1 −1 −1 −1 |
| | 1 1 1 −1 1 −1 1 −1 −1 1 1 −1 1 −1 −1 1 1 −1 −1 −1 −1 −1 1 1 −1 −1 −1 1 −1 1 1 |
| | −1 −1 1 1 1 1 1 −1 −1 1 1 1 −1 1 −1 −1 1 1 −1 −1 −1 −1 −1 1 1 −1 −1 1 −1 1 −1 |
| | −1 1 1 −1 −1 −1 −1 −1 1 1 1 1 −1 −1 −1 1 −1 1 1 −1 −1 1 1 1 1 1 −1 −1 1 1 1 −1 1 |
| | −1 −1 1 1 −1 −1 −1 −1 −1 1 1 −1 −1 −1 1 −1 1 1 −1 −1 1 1 1 1 1 −1 −1 1 1 −1 1 |
| | −1 1 1 −1 −1 1 1 1 1 1 −1 −1 1 1 1 1 −1 −1 1 1 1 1 1 −1 −1 1 1 −1 1 −1 1 1 −1 −1 |
| | 1 1 1 1 1 −1 −1 1 1 −1 1 −1 −1 −1 1 1 −1 −1 −1 −1 −1 1 1 −1 −1 1 −1 1 1 1 −1 |
| | −1 1 1 1 1 1 −1 −1 1 1 −1 1 −1 1 1 −1 −1 1 1 1 1 1 −1 −1 1 1 −1 1 −1 1 1 −1 −1 1 |
| | 1 1 1 1 −1 −1 1 1 −1 1 −1 −1 −1 1 1 −1 −1 −1 −1 −1 1 1 −1 −1 1 −1 1 1 1 −1 −1 |
| | 1 1 1 1 1 −1 −1 1 1 −1 1 −1 1 −1 −1 1 −1 1 −1 1 1 1 −1 −1 −1 −1 −1 −1 1 −1 −1 |
| | 1 −1 1 −1 1 1 1 −1 −1 −1 −1 −1 −1 −1 1 1 −1 1 −1 1 −1 −1 −1 1 1 1 1 1 1 1 −1 |
| | −1 1 −1 1 −1 1 1 1 −1 −1 −1 −1 −1 −1 1 −1 −1 1 −1 1 −1 1 1 1 −1 −1 −1 −1 −1 |
| | −1 1 −1 −1 1 −1 1 −1 1 1 1 −1 −1 −1 −1 −1 −1 −1 1 1 −1 1 −1 1 −1 −1 −1 1 1 1 1 |
| | 1 1 1 −1 −1 1 −1 1 −1 1 1 1 −1 −1 −1 −1 −1 −1 1 1 −1 −1 1 1 1 1 1 −1 −1 1 1 −1 |
| | 1 −1 −1 −1 1 1 −1 −1 −1 −1 −1 1 1 −1 −1 1 −1 1 −1 −1 1 1 −1 −1 −1 −1 −1 1 1 |
| | −1 −1 1 −1 1 −1 −1 1 1 −1 −1 −1 −1 −1 1 1 −1 −1 1 −1 1 −1 −1 1 1 −1 −1 −1 −1 |
| | −1 1 1 −1 −1 1 −1 1 1 1 −1 −1 1 1 1 1 1 −1 −1 1 1 −1 1 −1 1 1 −1 −1 1 1 1 1 1 −1 |
| | −1 1 1 −1 1 −1 1 1 −1 −1 1 1 1 1 1 −1 −1 1 1 −1 1 −1 1 −1 −1 1 −1 1 −1 1 1 1 −1 |
| | −1 −1 −1 −1 −1 −1 1 1 −1 1 −1 1 −1 −1 −1 1 1 1 1 1 1 −1 1 1 −1 1 −1 1 −1 −1 −1 |
| | 1 1 1 1 1 1 −1 1 1 −1 1 −1 1 −1 −1 −1 1 1 1 1 1 1 −1 1 1 −1 1 −1 1 −1 −1 −1 1 1 |
| | 1 1 1 1 1 −1 −1 1 −1 1 −1 1 1 1 −1 −1 −1 −1 −1 −1 1 −1 −1 1 −1 1 −1 1 1 1 −1 |
| | −1 −1 −1 −1 −1 1 −1 −1 1 −1 1 −1 1 1 1 −1 −1 −1 −1 −1 −1 1 1 −1 −1 1 1 1 1 −1 |
| | 1 1 −1 −1 1 −1 1 1 1 −1 −1 1 1 1 −1 1 1 −1 −1 1 −1 1 −1 −1 1 1 −1 −1 −1 −1 1 |
| | −1 −1 1 1 −1 1 −1 1 1 −1 −1 1 1 1 1 −1 1 1 −1 −1 1 −1 1 1 1 −1 −1 1 1 1 1 −1 1 1 |
| | −1 −1 1 −1 1 1 1 −1 −1 1 1 1 1 −1 1 1 −1 −1 1 −1 1 −1 −1 1 1 −1 −1 −1 −1 1 −1 |
| | −1 1 1 −1 1 −1 1 1 −1 −1 1 1 1 1 −1 1 1 −1 −1 1 −1 1 1 −1 −1 1 −1 1 −1 1 −1 −1 |
| | 1 1 1 1 1 1 1 −1 −1 1 −1 1 −1 1 −1 −1 1 1 1 1 1 1 −1 1 1 −1 1 −1 1 −1 1 1 −1 −1 |
| | −1 −1 −1 −1 1 −1 −1 1 −1 1 −1 1 −1 −1 1 1 1 1 1 1 1 −1 −1 1 −1 1 −1 1 −1 −1 1 |
| | 1 1 1 1 1 1 −1 −1 1 −1 1 −1 1 −1 −1 1 1 1 1 1 1 −1 1 1 −1 1 −1 1 −1 1 1 −1 −1 −1 |
| | −1 −1 −1 1 −1 −1 1 −1 1 −1 1 −1 −1 1 1 1 1 1 1 1 1 −1 −1 1 1 1 1 −1 1 1 −1 −1 1 |
| | −1 1 −1 −1 1 1 −1 −1 −1 −1 1 −1 −1 1 1 −1 1 −1 −1 −1 1 1 −1 −1 −1 −1 1 −1 −1 |
| | 1 1 −1 1 −1 −1 −1 1 1 −1 −1 −1 −1 1 −1 −1 1 1 −1 1 −1 −1 −1 1 1 −1 −1 −1 −1 1 |
| | −1 −1 1 1 −1 1 −1 1 1 −1 −1 1 1 1 1 −1 1 1 −1 −1 1 −1 1 1 1 −1 −1 1 1 1 1 −1 1 1 |
| | −1 −1 1 −1 1 1 1 −1 −1 1 1 1 1 −1 1 1 −1 −1 1 −1 1 1 −1 −1 1 −1 1 −1 1 −1 −1 1 |
| | 1 1 1 1 1 −1 1 1 −1 1 −1 1 −1 1 1 −1 −1 −1 −1 −1 −1 −1 1 1 −1 1 −1 1 −1 1 1 −1 |
| | −1 −1 −1 −1 −1 −1 1 1 −1 1 −1 1 −1 1 1 −1 −1 −1 −1 −1 −1 −1 1 1 −1 1 −1 1 −1 |
| | 1 1 −1 −1 −1 −1 −1 −1 1 −1 −1 1 −1 1 −1 1 −1 −1 1 1 1 1 1 1 1 −1 −1 1 −1 1 −1 |
| | 1 −1 −1 1 1 1 1 1 1 1 −1 −1 1 −1 1 −1 1 −1 −1 1 1 1 1 1 1 1 1 1 1 1 1 −1 −1 1 −1 |
| | 1 −1 1 −1 −1 1 1 1 1 1 1 1 −1 −1 1 −1 1 −1 1 −1 −1 1 1 1 1 1 1 1 −1 −1 1 −1 1 −1 |
| | 1 −1 −1 1 −1 −1 −1 −1 −1 −1 1 1 −1 1 −1 1 −1 1 1 −1 −1 −1 −1 −1 −1 −1 1 1 −1 |
| | 1 −1 1 −1 1 1 −1 −1 −1 −1 −1 −1 −1 1 1 −1 1 −1 1 −1 1 1 −1 −1 −1 −1 −1 −1 −1 |
| | 1 1 −1 1 −1 1 −1 1 1 −1 1 1 1 1 1 1 −1 −1 1 −1 1 −1 1 −1 −1 1 1 −1 1 −1 −1 1 1 |
| | −1 1 1 1 1 −1 −1 1 1 1 −1 1 −1 −1 1 1 −1 1 1 1 1 −1 −1 1 1 1 −1 1 −1 −1 1 1 −1 1 |
| | 1 1 1 −1 −1 1 1 −1 1 −1 1 1 −1 −1 1 −1 −1 −1 −1 1 1 −1 −1 −1 1 −1 1 1 −1 −1 1 |
| | −1 −1 −1 −1 1 1 −1 −1 −1 1 −1 1 1 −1 −1 1 −1 −1 −1 −1 1 1 −1 −1 −1 1 −1 1 1 |
| | −1 −1 1 −1 −1 −1 −1 1 1 −1 −1 1 −1 1 −1 −1 1 1 −1 1 1 1 1 −1 −1 1 1 1 1 1 1 1 1 |
| | −1 −1 1 −1 1 −1 1 −1 −1 1 −1 −1 −1 −1 −1 −1 1 1 −1 1 −1 1 −1 1 1 −1 1 1 1 1 1 |
| | 1 −1 −1 1 −1 1 −1 1 −1 −1 1 1 1 1 1 1 1 −1 −1 1 −1 1 −1 1 −1 −1 1 1 1 1 1 1 1 −1 |
| | −1 1 −1 1 −1 1 −1 −1 1 −1 −1 −1 −1 −1 −1 1 1 −1 1 −1 1 −1 1 1 −1 1 1 1 1 1 1 |
| | −1 −1 1 −1 1 −1 1 −1 −1 1 1 1 1 1 1 1 −1 −1 1 −1 1 −1 1 −1 −1 1 1 −1 1 −1 −1 1 |
| | 1 −1 1 1 1 1 −1 −1 1 1 −1 1 −1 1 1 −1 −1 1 −1 −1 −1 −1 1 1 −1 −1 1 −1 1 −1 −1 |
| | 1 1 −1 1 1 1 1 −1 −1 1 1 1 −1 1 −1 −1 1 1 −1 1 1 1 1 −1 −1 1 1 1 −1 1 −1 −1 1 1 |
| | −1 1 1 1 1 −1 −1 1 1 −1 1 −1 1 1 −1 −1 1 −1 −1 −1 −1 1 1 1 −1 −1 1 −1 1 −1 −1 1 |
| | 1 −1 1 1 1 1 −1 −1 1 1 1 −1 1 −1 −1 1 1 −1 1 1 1 1 −1 −1 1 1 1 1 1 1 1 1 −1 −1 |
| | −1 1 −1 1 −1 1 1 −1 1 1 1 1 1 1 −1 −1 −1 1 −1 1 −1 1 1 −1 1 1 1 1 1 1 −1 −1 −1 1 |
| | −1 1 −1 1 1 −1 −1 −1 −1 −1 −1 −1 1 1 1 −1 1 −1 1 −1 −1 1 −1 −1 −1 −1 −1 −1 1 |
| | 1 1 −1 1 −1 1 −1 −1 1 −1 −1 −1 −1 −1 −1 1 1 1 −1 1 −1 1 −1 −1 1 −1 −1 −1 −1 |
| | −1 −1 1 1 1 −1 1 −1 1 −1 −1 1 1 1 1 1 1 1 −1 −1 −1 1 −1 1 −1 1 1 −1 1 −1 1 −1 |
| | −1 1 1 −1 −1 −1 −1 −1 1 1 −1 −1 1 −1 1 −1 −1 1 1 −1 −1 −1 −1 −1 1 1 −1 −1 1 |
| | −1 1 −1 −1 1 1 −1 −1 −1 −1 −1 1 1 −1 −1 −1 1 −1 1 1 −1 −1 1 1 1 1 1 −1 −1 1 1 |
| | −1 1 −1 1 1 −1 −1 1 1 1 1 1 −1 −1 1 1 −1 1 −1 1 1 −1 −1 1 1 1 1 1 −1 −1 1 1 −1 1 |
| | −1 1 1 −1 −1 1 1 1 1 1 −1 −1 1 1 1 −1 1 −1 −1 1 1 −1 −1 −1 −1 −1 1 1 −1 −1 1 1 |
| | 1 1 1 1 −1 −1 −1 1 −1 1 −1 1 1 −1 −1 −1 −1 −1 −1 −1 1 1 1 −1 1 −1 1 −1 −1 1 1 |
| | 1 1 1 1 1 −1 −1 −1 1 −1 1 −1 1 1 −1 1 1 1 1 1 1 −1 −1 −1 1 −1 1 −1 1 1 −1 1 1 1 |
| | 1 1 1 −1 −1 −1 1 −1 1 −1 1 1 −1 −1 −1 −1 −1 −1 −1 1 1 1 −1 1 −1 1 −1 −1 1 1 1 |
| | 1 1 1 1 −1 −1 −1 1 −1 1 −1 1 1 −1 1 1 1 1 1 1 −1 −1 −1 1 −1 1 −1 1 1 −1 1 −1 1 |
| | −1 −1 1 1 −1 −1 −1 −1 −1 1 1 −1 −1 −1 1 −1 1 1 −1 −1 1 1 1 1 1 −1 −1 1 1 1 −1 |
| | 1 −1 −1 1 1 −1 −1 −1 −1 −1 1 1 −1 −1 1 −1 1 −1 −1 1 1 −1 −1 −1 −1 −1 1 1 −1 |
| | −1 1 −1 1 −1 −1 1 1 −1 −1 −1 −1 −1 1 1 −1 −1 −1 1 −1 1 1 −1 −1 1 1 1 1 1 −1 −1 |
| | 1 1 1 −1 1 −1 −1 1 1 −1 −1 −1 −1 −1 1 1 −1 −1 1 −1 1 −1 −1 1 1 −1 −1 −1 −1 −1 |
| | 1 1 −1 −1 1 1 −1 −1 1 1 1 1 1 −1 −1 1 1 −1 1 −1 1 1 −1 −1 1 1 1 1 1 −1 −1 1 1 −1 |
| | 1 −1 −1 −1 1 1 −1 −1 −1 −1 −1 1 1 −1 −1 1 −1 1 1 1 −1 −1 1 1 1 1 1 −1 −1 1 1 |
| | −1 1 −1 −1 −1 1 1 −1 −1 −1 −1 −1 1 1 −1 −1 1 −1 1 −1 −1 1 1 −1 −1 −1 −1 −1 1 |
| | 1 −1 −1 1 −1 1 1 1 −1 −1 1 1 1 1 1 −1 −1 1 1 −1 1 −1 −1 −1 1 1 −1 −1 −1 −1 −1 |
| | 1 1 −1 −1 1 −1 1 1 −1 −1 1 −1 1 −1 1 1 1 −1 −1 −1 −1 −1 −1 1 −1 −1 1 −1 1 −1 1 |
| | 1 1 −1 −1 −1 −1 −1 −1 −1 1 1 −1 1 −1 1 −1 −1 −1 1 1 1 1 1 1 1 −1 −1 1 −1 1 −1 |
| | 1 1 1 −1 −1 −1 −1 −1 −1 −1 1 1 −1 1 −1 1 −1 −1 −1 1 1 1 1 1 1 −1 1 1 −1 1 −1 1 |
| | −1 −1 −1 1 1 1 1 1 1 1 −1 −1 1 −1 1 −1 1 1 1 −1 −1 −1 −1 −1 −1 −1 1 1 −1 1 −1 |
| | 1 −1 −1 −1 1 1 1 1 1 1 1 1 −1 −1 1 1 1 1 1 −1 −1 1 1 −1 1 −1 −1 −1 1 1 −1 −1 −1 |
| | −1 −1 1 1 −1 −1 1 −1 1 −1 −1 1 1 −1 −1 −1 −1 −1 1 1 −1 −1 1 −1 1 −1 −1 1 1 −1 |
| | −1 −1 −1 −1 1 1 −1 −1 1 −1 1 1 1 −1 −1 1 1 1 1 1 −1 −1 1 1 −1 1 −1 −1 −1 1 1 |
| | −1 −1 −1 −1 −1 1 1 −1 −1 1 −1 1 −1 −1 1 1 −1 −1 −1 −1 −1 1 1 −1 −1 1 −1 1 −1 |
| | −1 1 1 −1 −1 −1 −1 −1 1 1 −1 −1 1 −1 1 1 −1 −1 1 −1 1 −1 1 1 1 −1 −1 −1 −1 −1 |
| | −1 −1 1 1 −1 1 −1 1 −1 −1 −1 1 1 1 1 1 1 −1 1 1 −1 1 −1 1 −1 −1 −1 1 1 1 1 1 1 |
| | −1 1 1 −1 1 −1 1 −1 −1 −1 1 1 1 1 1 1 1 −1 −1 1 −1 1 −1 1 1 1 −1 −1 −1 −1 −1 |
| | −1 −1 1 1 −1 1 −1 1 −1 −1 −1 1 1 1 1 1 1 −1 1 1 −1 1 −1 1 −1 −1 −1 1 1 1 1 1 1 |
| | −1 1 1 −1 1 −1 1 −1 −1 −1 1 1 1 1 1 1 1 1 −1 −1 1 1 1 1 −1 1 1 −1 −1 1 −1 1 1 1 |
| | −1 −1 1 1 1 1 −1 1 1 −1 −1 1 −1 1 −1 −1 1 1 −1 −1 −1 −1 1 −1 −1 1 1 −1 1 −1 1 |
| | 1 −1 −1 1 1 1 1 −1 1 1 −1 −1 1 −1 1 −1 −1 1 1 −1 −1 −1 −1 1 −1 −1 1 1 −1 1 −1 |
| | −1 −1 1 1 −1 −1 −1 −1 1 −1 −1 1 1 −1 1 −1 1 1 −1 −1 1 1 1 1 −1 1 1 −1 −1 1 −1 |
| | 1 −1 −1 1 1 −1 −1 −1 −1 1 −1 −1 1 1 −1 1 −1 1 −1 −1 1 −1 1 −1 1 −1 −1 1 1 1 1 |
| | 1 1 1 −1 −1 1 −1 1 −1 1 −1 −1 1 1 1 1 1 1 −1 1 1 −1 1 −1 1 −1 1 1 −1 −1 −1 −1 |
| | −1 −1 1 −1 −1 1 −1 1 −1 1 −1 −1 1 1 1 1 1 1 −1 1 1 −1 1 −1 1 −1 1 1 −1 −1 −1 |
| | −1 −1 −1 −1 1 1 −1 1 −1 1 −1 1 1 −1 −1 −1 −1 −1 −1 1 −1 −1 1 −1 1 −1 1 −1 −1 |
| | 1 1 1 1 1 1 −1 1 1 −1 1 −1 1 −1 1 1 −1 −1 −1 −1 −1 −1 1 1 −1 −1 1 1 1 1 −1 1 1 |
| | −1 −1 1 −1 1 −1 −1 1 1 −1 −1 −1 −1 1 −1 −1 1 1 −1 1 −1 −1 −1 1 1 −1 −1 −1 −1 |
| | 1 −1 −1 1 1 −1 1 −1 −1 −1 1 1 −1 −1 −1 −1 1 −1 −1 1 1 −1 1 −1 1 1 −1 −1 1 1 1 |
| | 1 −1 1 1 −1 −1 1 −1 1 −1 −1 1 1 −1 −1 −1 −1 1 −1 −1 1 1 −1 1 −1 −1 −1 1 1 −1 |
| | −1 −1 −1 1 −1 −1 1 1 −1 1 −1 −1 −1 1 1 −1 −1 −1 −1 1 −1 −1 1 1 −1 1 −1 1 −1 |
| | −1 1 −1 1 −1 1 −1 −1 1 1 1 1 1 1 −1 1 1 −1 1 −1 1 −1 1 1 −1 −1 −1 −1 −1 −1 −1 |
| | 1 1 −1 1 −1 1 −1 1 1 −1 −1 −1 −1 −1 −1 −1 1 1 −1 1 −1 1 −1 1 1 −1 −1 −1 −1 −1 |
| | −1 1 −1 −1 1 −1 1 −1 1 −1 −1 1 1 1 1 1 1 −1 1 1 −1 1 −1 1 −1 1 1 −1 −1 −1 −1 |
| | −1 −1 −1 1 1 −1 1 −1 1 −1 1 1 −1 −1 −1 −1 −1 −1 −1 1 1 −1 1 −1 1 −1 1 1 −1 −1 |
| | −1 −1 −1 −1 −1 −1 −1 −1 −1 −1 1 1 −1 1 −1 1 −1 1 1 −1 −1 −1 −1 −1 −1 −1 1 1 |
| | −1 1 −1 1 −1 1 1 −1 −1 −1 −1 −1 −1 −1 1 1 −1 1 −1 1 −1 1 1 −1 1 1 1 1 1 1 −1 |
| | −1 1 −1 1 −1 1 −1 −1 1 −1 −1 −1 −1 −1 −1 1 1 −1 1 −1 1 −1 1 1 −1 −1 −1 −1 −1 |
| | −1 −1 1 1 −1 1 −1 1 −1 1 1 −1 −1 −1 −1 −1 −1 −1 1 1 −1 1 −1 1 −1 1 1 −1 1 1 1 |
| | 1 1 1 −1 −1 1 −1 1 −1 1 −1 −1 1 −1 1 −1 1 1 −1 −1 1 −1 −1 −1 −1 1 1 −1 −1 −1 1 |
| | −1 1 1 −1 −1 1 −1 −1 −1 −1 1 1 −1 −1 −1 1 −1 1 1 −1 −1 1 −1 −1 −1 −1 1 1 −1 |
| | −1 1 −1 1 −1 −1 1 1 −1 1 1 1 1 −1 −1 1 1 −1 1 −1 1 1 −1 −1 1 −1 −1 −1 −1 1 1 |
| | −1 −1 −1 1 −1 1 1 −1 −1 1 −1 −1 −1 −1 1 1 −1 −1 −1 1 −1 1 1 −1 −1 1 −1 −1 −1 |
| | −1 1 1 −1 −1 1 −1 1 −1 −1 1 1 −1 1 1 1 1 −1 −1 1 1 −1 −1 −1 −1 −1 −1 1 1 −1 1 |
| | −1 1 −1 1 1 −1 1 1 1 1 1 1 −1 −1 1 −1 1 −1 1 −1 −1 1 −1 −1 −1 −1 −1 −1 1 1 −1 |
| | 1 −1 1 −1 1 1 −1 −1 −1 −1 −1 −1 −1 1 1 −1 1 −1 1 −1 1 1 −1 1 1 1 1 1 1 −1 −1 1 |
| | −1 1 −1 1 −1 −1 1 −1 −1 −1 −1 −1 −1 1 1 −1 1 −1 1 −1 1 1 −1 1 1 1 1 1 1 −1 −1 |
| | 1 −1 1 −1 1 −1 −1 1 1 1 1 1 1 1 −1 −1 1 −1 1 −1 1 −1 −1 1 −1 1 −1 1 1 −1 −1 1 |
| | −1 −1 −1 −1 1 1 −1 −1 1 −1 1 −1 −1 1 1 −1 1 1 1 1 −1 −1 1 1 −1 1 −1 1 1 −1 −1 |
| | 1 −1 −1 −1 −1 1 1 −1 −1 −1 1 −1 1 1 −1 −1 1 −1 −1 −1 −1 1 1 −1 −1 1 −1 1 −1 |
| | −1 1 1 −1 1 1 1 1 −1 −1 1 1 −1 1 −1 1 1 −1 −1 1 −1 −1 −1 −1 1 1 −1 −1 1 −1 1 |
| | −1 −1 1 1 −1 1 1 1 1 −1 −1 1 1 1 −1 1 −1 −1 1 1 −1 1 1 1 1 −1 −1 1 1 −1 −1 −1 |
| | −1 −1 −1 1 1 1 −1 1 −1 1 −1 −1 1 −1 −1 −1 −1 −1 −1 1 1 1 −1 1 −1 1 −1 −1 1 −1 |
| | −1 −1 −1 −1 −1 1 1 1 −1 1 −1 1 −1 −1 1 1 1 1 1 1 1 −1 −1 −1 1 −1 1 −1 1 1 −1 |
| | −1 −1 −1 −1 −1 −1 1 1 1 −1 1 −1 1 −1 −1 1 −1 −1 −1 −1 −1 −1 1 1 1 −1 1 −1 1 |
| | −1 −1 1 −1 −1 −1 −1 −1 −1 1 1 1 −1 1 −1 1 −1 −1 1 1 1 1 1 1 1 −1 −1 −1 1 −1 1 |
| | −1 1 1 −1 −1 1 −1 1 1 −1 −1 1 1 1 1 1 −1 −1 1 1 −1 1 −1 1 1 −1 −1 1 1 1 1 1 −1 |
| | −1 1 1 −1 1 −1 1 1 −1 −1 1 1 1 1 1 −1 −1 1 1 1 −1 1 −1 −1 1 1 −1 −1 −1 −1 −1 1 |
| | 1 −1 −1 −1 1 −1 1 1 −1 −1 1 1 1 1 1 −1 −1 1 1 −1 1 −1 1 1 −1 −1 1 1 1 1 1 −1 −1 |
| | 1 1 −1 1 −1 1 1 −1 −1 1 1 1 1 1 −1 −1 1 1 1 −1 1 −1 −1 1 1 −1 −1 −1 −1 −1 1 1 |
| | −1 −1 −1 −1 −1 −1 −1 −1 1 1 1 −1 1 −1 1 −1 −1 1 1 1 1 1 1 1 −1 −1 −1 1 −1 1 −1 |
| | 1 1 −1 −1 −1 −1 −1 −1 −1 1 1 1 −1 1 −1 1 −1 −1 1 −1 −1 −1 −1 −1 −1 1 1 1 −1 1 |
| | −1 1 −1 −1 1 1 1 1 1 1 1 −1 −1 −1 1 −1 1 −1 1 1 −1 −1 −1 −1 −1 −1 1 1 1 1 −1 |
| | 1 −1 1 −1 −1 1 1 1 1 1 1 1 −1 −1 −1 1 −1 1 −1 1 1 −1 1 1 1 1 1 1 −1 −1 −1 1 −1 1 |
| | −1 1 1 −1 −1 1 −1 1 1 −1 −1 1 1 1 1 1 −1 −1 1 1 1 −1 1 −1 −1 1 1 −1 −1 −1 −1 |
| | −1 1 1 −1 −1 −1 1 −1 1 1 −1 −1 1 1 1 1 1 −1 −1 1 1 −1 1 −1 1 1 −1 −1 1 1 1 1 1 |
| | −1 −1 1 1 1 −1 1 −1 −1 1 1 −1 −1 −1 −1 −1 1 1 −1 −1 −1 1 −1 1 1 −1 −1 1 1 1 1 |
| | 1 −1 −1 1 1 1 −1 1 −1 −1 1 1 −1 −1 −1 −1 −1 1 1 −1 −1 1 −1 1 −1 −1 1 1 −1 −1 |
| | −1 −1 −1 1 1 −1 −1 −1 −1 1 1 −1 −1 −1 −1 −1 1 1 −1 −1 1 −1 1 −1 −1 1 1 −1 −1 |
| | −1 −1 −1 1 1 −1 −1 1 −1 1 1 1 −1 −1 1 1 1 1 1 −1 −1 1 1 −1 1 −1 −1 −1 1 1 −1 |
| | −1 −1 −1 −1 1 1 −1 −1 1 −1 1 −1 −1 1 1 −1 −1 −1 −1 −1 1 1 −1 −1 1 −1 1 −1 −1 |
| | 1 1 −1 −1 −1 −1 −1 1 1 −1 −1 1 −1 1 1 1 −1 −1 1 1 1 1 1 −1 −1 1 1 −1 1 −1 −1 |
| | −1 1 1 −1 −1 −1 −1 −1 1 1 −1 −1 1 −1 1 −1 1 1 −1 1 −1 1 −1 −1 −1 1 1 1 1 1 1 |
| | −1 1 1 −1 1 −1 1 −1 −1 −1 1 1 1 1 1 1 1 −1 −1 1 −1 1 −1 1 1 1 −1 −1 −1 −1 −1 |
| | −1 −1 1 1 −1 1 −1 1 −1 −1 −1 1 1 1 1 1 −1 1 1 −1 1 −1 1 −1 −1 −1 1 1 1 1 1 1 |
| | −1 1 1 −1 1 −1 1 −1 −1 −1 1 1 1 1 1 1 1 −1 −1 1 −1 1 −1 1 1 1 −1 −1 −1 −1 −1 |
| | −1 −1 1 1 −1 1 −1 1 −1 −1 −1 1 1 1 1 1 1 −1 −1 1 1 −1 −1 −1 −1 −1 1 1 −1 −1 1 |
| | −1 1 1 1 −1 −1 1 1 1 1 1 −1 −1 1 1 −1 1 −1 1 1 −1 −1 1 1 1 1 1 −1 −1 1 1 −1 1 −1 |
| | 1 1 −1 −1 1 1 1 1 1 −1 −1 1 1 −1 1 −1 1 1 −1 −1 1 1 1 1 1 −1 −1 1 1 −1 1 −1 −1 |
| | −1 1 1 −1 −1 −1 −1 −1 1 1 −1 −1 1 −1 1 −1 −1 1 1 −1 −1 −1 −1 −1 1 1 −1 −1 1 |
| | −1 1 −1 −1 1 1 −1 −1 −1 −1 −1 1 1 −1 −1 1 −1 1 −1 1 1 −1 1 −1 1 −1 −1 −1 1 1 1 |
| | 1 1 1 1 −1 −1 1 −1 1 −1 1 1 1 −1 −1 −1 −1 −1 −1 1 −1 −1 1 −1 1 −1 1 1 1 −1 −1 |
| | −1 −1 −1 −1 1 −1 −1 1 −1 1 −1 1 1 1 −1 −1 −1 −1 −1 −1 1 −1 −1 1 −1 1 −1 1 1 1 |
| | −1 −1 −1 −1 −1 −1 −1 1 1 −1 1 −1 1 −1 −1 −1 1 1 1 1 1 1 −1 1 1 −1 1 −1 1 −1 −1 |
| | −1 1 1 1 1 1 1 −1 1 1 −1 1 −1 1 −1 −1 −1 1 1 1 1 1 1 −1 −1 1 1 −1 −1 −1 −1 1 −1 |
| | −1 1 1 −1 1 −1 −1 −1 1 1 −1 −1 −1 −1 1 −1 −1 1 1 −1 1 −1 1 1 −1 −1 1 1 1 1 −1 |
| | 1 1 −1 −1 1 −1 1 −1 −1 1 1 −1 −1 −1 −1 1 −1 −1 1 1 −1 1 −1 −1 −1 1 1 −1 −1 −1 |
| | −1 1 −1 −1 1 1 −1 1 −1 −1 −1 1 1 −1 −1 −1 −1 1 −1 −1 1 1 −1 1 −1 1 1 −1 −1 1 1 |
| | 1 1 −1 1 1 −1 −1 1 −1 1 −1 −1 1 1 −1 −1 −1 −1 1 −1 −1 1 1 −1 1 −1 −1 1 1 −1 1 |
| | −1 1 −1 1 1 −1 −1 −1 −1 −1 −1 −1 1 1 −1 1 −1 1 −1 1 1 −1 −1 −1 −1 −1 −1 1 −1 |
| | −1 1 −1 1 −1 1 −1 −1 1 1 1 1 1 1 −1 1 1 −1 1 −1 1 −1 1 1 −1 −1 −1 −1 −1 −1 −1 |
| | 1 1 −1 1 −1 1 −1 1 1 −1 −1 −1 −1 −1 −1 −1 1 1 −1 1 −1 1 −1 1 1 −1 −1 −1 −1 −1 |
| | −1 1 −1 −1 1 −1 1 −1 1 −1 −1 1 1 1 1 1 1 −1 1 1 −1 1 −1 1 −1 1 1 −1 −1 −1 −1 |
| | −1 −1 −1 −1 1 1 −1 −1 −1 −1 1 −1 −1 1 1 −1 1 −1 1 1 −1 −1 1 1 1 1 −1 1 1 −1 −1 |
| | 1 −1 1 1 1 −1 −1 1 1 1 1 −1 1 1 −1 −1 1 −1 1 1 1 −1 −1 1 1 1 1 −1 1 1 −1 −1 1 −1 |
| | 1 1 1 −1 −1 1 1 1 1 −1 1 1 −1 −1 1 −1 1 −1 −1 1 1 −1 −1 −1 −1 1 −1 −1 1 1 −1 1 |
| | −1 −1 −1 1 1 −1 −1 −1 −1 1 −1 −1 1 1 −1 1 −1 −1 −1 1 1 −1 −1 −1 −1 1 −1 −1 1 |
| | 1 −1 1 −1 −1 1 1 −1 1 −1 1 −1 1 1 −1 −1 −1 −1 −1 −1 1 −1 −1 1 −1 1 −1 1 −1 −1 |
| | 1 1 1 1 1 1 1 −1 −1 1 −1 1 −1 1 −1 −1 1 1 1 1 1 1 1 −1 −1 1 −1 1 −1 1 −1 −1 1 1 |
| | 1 1 1 1 1 −1 −1 1 −1 1 −1 1 −1 −1 1 1 1 1 1 1 −1 1 1 −1 1 −1 1 −1 1 1 −1 −1 −1 |
| | −1 −1 −1 −1 1 1 −1 1 −1 1 −1 1 1 −1 −1 −1 −1 −1 −1 −1 1 1 −1 1 −1 1 −1 1 1 −1 |
| | −1 −1 −1 −1 −1 1 1 1 1 1 1 −1 −1 1 −1 1 −1 1 −1 −1 1 1 1 1 1 1 1 −1 −1 1 −1 1 |
| | −1 1 −1 −1 1 1 1 1 1 1 1 −1 −1 1 −1 1 −1 1 −1 −1 1 −1 −1 −1 −1 −1 −1 1 1 −1 1 |
| | −1 1 −1 1 1 −1 −1 −1 −1 −1 −1 −1 1 1 −1 1 −1 1 −1 1 1 −1 −1 −1 −1 −1 −1 −1 1 |
| | 1 −1 1 −1 1 −1 1 1 −1 −1 −1 −1 −1 −1 −1 1 1 −1 1 −1 1 −1 1 1 −1 1 1 1 1 1 1 −1 |
| | −1 1 −1 1 −1 1 −1 −1 1 1 −1 1 −1 −1 1 1 −1 1 1 1 1 −1 −1 1 1 1 −1 1 −1 −1 1 1 |
| | −1 1 1 1 1 −1 −1 1 1 1 −1 1 −1 −1 1 1 −1 1 1 1 1 −1 −1 1 1 −1 1 −1 1 1 −1 −1 1 |
| | −1 −1 −1 −1 1 1 −1 −1 −1 1 −1 1 1 −1 −1 1 −1 −1 −1 −1 1 1 −1 −1 −1 1 −1 1 1 |
| | −1 −1 1 −1 −1 −1 −1 1 1 −1 −1 −1 1 −1 1 1 −1 −1 1 −1 −1 −1 −1 1 1 −1 −1 1 −1 |
| | 1 −1 −1 1 1 −1 1 1 1 1 −1 −1 1 1 1 1 1 1 1 1 −1 −1 1 −1 1 −1 1 −1 −1 1 −1 −1 −1 |
| | −1 −1 −1 1 1 −1 1 −1 1 −1 1 1 −1 1 1 1 1 1 1 −1 −1 1 −1 1 −1 1 −1 −1 1 1 1 1 1 1 |
| | 1 −1 −1 1 −1 1 −1 1 −1 −1 1 1 1 1 1 1 1 −1 −1 1 −1 1 −1 1 −1 −1 1 −1 −1 −1 −1 |
| | −1 −1 1 1 −1 1 −1 1 −1 1 1 −1 1 1 1 1 1 1 −1 −1 1 −1 1 −1 1 −1 −1 1 1 1 1 1 1 1 |
| | −1 −1 1 −1 1 −1 1 −1 −1 1 1 −1 1 −1 −1 1 1 −1 1 1 1 1 −1 −1 1 1 −1 1 −1 1 1 −1 |
| | −1 1 −1 −1 −1 −1 1 1 −1 −1 1 −1 1 −1 −1 1 1 −1 1 1 1 1 −1 −1 1 1 1 −1 1 −1 −1 |
| | 1 1 −1 1 1 1 1 −1 −1 1 1 1 −1 1 −1 −1 1 1 −1 1 1 1 1 −1 −1 1 1 −1 1 −1 1 1 −1 −1 |
| | 1 −1 −1 −1 −1 1 1 −1 −1 1 −1 1 −1 −1 1 1 −1 1 1 1 1 −1 −1 1 1 1 −1 1 −1 −1 1 1 |
| | −1 1 1 1 1 −1 −1 1 1 1 1 1 1 1 1 −1 −1 −1 1 −1 1 −1 1 1 −1 1 1 1 1 1 1 −1 −1 −1 |
| | 1 −1 1 −1 1 1 −1 1 1 1 1 1 1 −1 −1 −1 1 −1 1 −1 1 1 −1 −1 −1 −1 −1 −1 −1 1 1 1 |
| | −1 1 −1 1 −1 −1 1 −1 −1 −1 −1 −1 −1 1 1 1 −1 1 −1 1 −1 −1 1 −1 −1 −1 −1 −1 |
| | −1 1 1 1 −1 1 −1 1 −1 −1 1 −1 −1 −1 −1 −1 −1 1 1 1 −1 1 −1 1 −1 −1 1 1 1 1 1 1 |
| | 1 −1 −1 −1 1 −1 1 −1 1 1 −1 1 −1 1 −1 −1 1 1 −1 −1 −1 −1 −1 1 1 −1 −1 1 −1 1 |
| | −1 −1 1 1 −1 −1 −1 −1 −1 1 1 −1 −1 1 −1 1 −1 −1 1 1 −1 −1 −1 −1 −1 1 1 −1 −1 |
| | −1 1 −1 1 1 −1 −1 1 1 1 1 1 −1 −1 1 1 −1 1 −1 1 1 −1 −1 1 1 1 1 1 −1 −1 1 1 −1 1 |
| | −1 1 1 −1 −1 1 1 1 1 1 −1 −1 1 1 −1 1 −1 1 1 −1 −1 1 1 1 1 1 −1 −1 1 1 −1 1 −1 |
| | −1 1 1 −1 −1 −1 −1 −1 1 1 −1 −1 1 1 1 1 1 1 −1 −1 −1 1 −1 1 −1 1 1 −1 −1 −1 −1 |
| | −1 −1 −1 1 1 1 −1 1 −1 1 −1 −1 1 1 1 1 1 1 1 −1 −1 −1 1 −1 1 −1 1 1 −1 1 1 1 1 1 |
| | 1 −1 −1 −1 1 −1 1 −1 1 1 −1 1 1 1 1 1 1 −1 −1 −1 1 −1 1 −1 1 1 −1 −1 −1 −1 −1 |
| | −1 −1 1 1 1 −1 1 −1 1 −1 −1 1 1 1 1 1 1 1 −1 −1 −1 1 −1 1 −1 1 1 −1 1 1 1 1 1 1 |
| | −1 −1 −1 1 −1 1 −1 1 1 −1 1 −1 1 −1 −1 1 1 −1 −1 −1 −1 −1 1 1 −1 −1 −1 1 −1 1 |
| | 1 −1 −1 1 1 1 1 1 −1 −1 1 1 1 −1 1 −1 −1 1 1 −1 −1 −1 −1 −1 1 1 −1 −1 1 −1 1 |
| | −1 −1 1 1 −1 −1 −1 −1 −1 1 1 −1 −1 1 −1 1 −1 −1 1 1 −1 −1 −1 −1 −1 1 1 −1 −1 |
| | −1 1 −1 1 1 −1 −1 1 1 1 1 1 −1 −1 1 1 1 −1 1 −1 −1 1 1 −1 −1 −1 −1 −1 1 1 −1 |
| | −1 1 −1 1 −1 −1 1 1 −1 −1 −1 −1 −1 1 1 −1 −1 1 1 −1 −1 1 1 1 1 1 −1 −1 1 1 −1 |
| | 1 −1 1 1 −1 −1 1 1 1 1 1 −1 −1 1 1 −1 1 −1 −1 −1 1 1 −1 −1 −1 −1 −1 1 1 −1 −1 |
| | 1 −1 1 1 1 −1 −1 1 1 1 1 1 −1 −1 1 1 −1 1 −1 −1 −1 1 1 −1 −1 −1 −1 −1 1 1 −1 |
| | −1 1 −1 1 −1 −1 1 1 −1 −1 −1 −1 −1 1 1 −1 −1 1 −1 1 1 1 −1 −1 1 1 1 1 1 −1 −1 |
| | 1 1 −1 1 −1 −1 −1 1 1 −1 −1 −1 −1 −1 1 1 −1 −1 1 −1 1 1 −1 −1 1 −1 1 −1 1 1 1 |
| | −1 −1 −1 −1 −1 −1 1 −1 −1 1 −1 1 −1 1 1 1 −1 −1 −1 −1 −1 −1 −1 1 1 −1 1 −1 1 |
| | −1 −1 −1 1 1 1 1 1 1 1 −1 −1 1 −1 1 −1 1 1 1 −1 −1 −1 −1 −1 −1 −1 1 1 −1 1 −1 |
| | 1 −1 −1 −1 1 1 1 1 1 1 −1 1 1 −1 1 −1 1 −1 −1 −1 1 1 1 1 1 1 1 −1 −1 1 −1 1 −1 1 |
| | 1 1 −1 −1 −1 −1 −1 −1 −1 1 1 −1 1 −1 1 −1 −1 −1 1 1 1 1 1 1 1 1 −1 −1 1 1 1 1 1 |
| | −1 −1 1 1 −1 1 −1 −1 −1 1 1 −1 −1 −1 −1 −1 1 1 −1 −1 1 −1 1 −1 −1 1 1 −1 −1 |
| | −1 −1 −1 1 1 −1 −1 1 −1 1 −1 −1 1 1 −1 −1 −1 −1 −1 1 1 −1 −1 1 −1 1 1 1 −1 −1 |
| | 1 1 1 1 1 −1 −1 1 1 −1 1 −1 −1 −1 1 1 −1 −1 −1 −1 −1 1 1 −1 −1 1 −1 1 −1 −1 1 |
| | 1 −1 −1 −1 −1 −1 1 1 −1 −1 1 −1 1 −1 −1 1 1 −1 −1 −1 −1 −1 1 1 −1 −1 1 −1 1 1 |
| | −1 −1 1 −1 1 −1 1 1 1 −1 −1 −1 −1 −1 −1 −1 1 1 −1 1 −1 1 −1 −1 −1 1 1 1 1 1 1 |
| | −1 1 1 −1 1 −1 1 −1 −1 −1 1 1 1 1 1 1 −1 1 1 −1 1 −1 1 −1 −1 −1 1 1 1 1 1 1 1 −1 |
| | −1 1 −1 1 −1 1 1 1 −1 −1 −1 −1 −1 −1 −1 1 1 −1 1 −1 1 −1 −1 −1 1 1 1 1 1 1 −1 |
| | 1 1 −1 1 −1 1 −1 −1 −1 1 1 1 1 1 1 −1 1 1 −1 1 −1 1 −1 −1 −1 1 1 1 1 1 1 1 1 −1 |
| | −1 1 1 1 1 −1 1 1 −1 −1 1 −1 1 1 1 −1 −1 1 1 1 1 −1 1 1 −1 −1 1 −1 1 −1 −1 1 1 |
| | −1 −1 −1 −1 1 −1 −1 1 1 −1 1 −1 1 1 −1 −1 1 1 1 1 −1 1 1 −1 −1 1 −1 1 −1 −1 1 |
| | 1 −1 −1 −1 −1 1 −1 −1 1 1 −1 1 −1 −1 −1 1 1 −1 −1 −1 −1 1 −1 −1 1 1 −1 1 −1 1 |
| | 1 −1 −1 1 1 1 1 −1 1 1 −1 −1 1 −1 1 −1 −1 1 1 −1 −1 −1 −1 1 −1 −1 1 1 −1 1 −1 |
| | 1 −1 −1 1 −1 1 −1 1 −1 −1 1 1 1 1 1 1 1 −1 −1 1 −1 1 −1 1 −1 −1 1 1 1 1 1 1 −1 1 |
| | 1 −1 1 −1 1 −1 1 1 −1 −1 −1 −1 −1 −1 1 −1 −1 1 −1 1 −1 1 −1 −1 1 1 1 1 1 1 −1 |
| | 1 1 −1 1 −1 1 −1 1 1 −1 −1 −1 −1 −1 −1 −1 1 1 −1 1 −1 1 −1 1 1 −1 −1 −1 −1 −1 |
| | −1 1 −1 −1 1 −1 1 −1 1 −1 −1 1 1 1 1 1 1 −1 1 1 −1 1 −1 1 −1 1 1 −1 −1 −1 −1 |
| | −1 −1 1 1 −1 −1 1 1 1 1 −1 1 1 −1 −1 1 −1 1 −1 −1 1 1 −1 −1 −1 −1 1 −1 −1 1 1 |
| | −1 1 −1 −1 −1 1 1 −1 −1 −1 −1 1 −1 −1 1 1 −1 1 −1 −1 −1 1 1 −1 −1 −1 −1 1 −1 |
| | −1 1 1 −1 1 −1 1 1 −1 −1 1 1 1 1 −1 1 1 −1 −1 1 −1 1 −1 −1 1 1 −1 −1 −1 −1 1 |
| | −1 −1 1 1 −1 1 −1 −1 −1 1 1 −1 −1 −1 −1 1 −1 −1 1 1 −1 1 −1 −1 −1 1 1 −1 −1 |
| | −1 −1 1 −1 −1 1 1 −1 1 −1 1 −1 −1 1 −1 1 −1 1 −1 −1 1 1 1 1 1 1 −1 1 1 −1 1 −1 |
| | 1 −1 1 1 −1 −1 −1 −1 −1 −1 −1 1 1 −1 1 −1 1 −1 1 1 −1 −1 −1 −1 −1 −1 −1 1 1 |
| | −1 1 −1 1 −1 1 1 −1 −1 −1 −1 −1 −1 1 −1 −1 1 −1 1 −1 1 −1 −1 1 1 1 1 1 1 −1 1 |
| | 1 −1 1 −1 1 −1 1 1 −1 −1 −1 −1 −1 −1 −1 1 1 −1 1 −1 1 −1 1 1 −1 −1 −1 −1 −1 |
| | −1 −1 1 1 −1 1 −1 1 −1 1 1 −1 −1 −1 −1 −1 −1 |
| 15 | 1 1 1 −1 1 1 1 −1 1 1 1 −1 1 1 1 −1 1 1 1 −1 −1 −1 −1 1 1 1 1 −1 −1 −1 −1 1 1 1 |
| | 1 −1 1 1 1 −1 1 1 1 −1 1 1 1 −1 1 1 1 −1 −1 −1 −1 1 1 1 1 −1 −1 −1 −1 1 1 1 1 −1 |
| | −1 −1 −1 1 1 1 1 −1 −1 −1 −1 1 1 1 1 −1 1 1 1 −1 1 1 1 −1 1 1 1 −1 1 1 1 −1 −1 |
| | −1 −1 1 1 1 1 −1 −1 −1 −1 1 1 1 1 −1 1 1 1 −1 1 1 1 −1 1 1 1 −1 1 1 1 −1 1 1 1 |
| | −1 −1 −1 −1 1 −1 −1 −1 1 1 1 1 −1 −1 −1 −1 1 −1 −1 −1 1 1 1 1 −1 1 1 1 −1 1 1 |
| | 1 −1 −1 −1 −1 1 −1 −1 −1 1 1 1 1 −1 −1 −1 −1 1 −1 −1 −1 1 1 1 1 −1 1 1 1 −1 −1 |
| | −1 −1 1 −1 −1 −1 1 1 1 1 −1 1 1 1 −1 1 1 1 −1 −1 −1 −1 1 −1 −1 −1 1 1 1 1 −1 |
| | −1 −1 −1 1 −1 −1 −1 1 1 1 1 −1 1 1 1 −1 1 1 1 −1 −1 −1 −1 1 −1 −1 −1 1 1 1 −1 |
| | 1 1 1 −1 1 1 1 −1 1 1 1 −1 1 −1 −1 1 −1 1 1 −1 1 −1 −1 1 −1 1 1 −1 1 1 1 −1 1 1 |
| | 1 −1 1 1 1 −1 1 1 1 −1 1 −1 −1 1 −1 1 1 −1 1 −1 −1 1 −1 1 1 −1 1 1 1 −1 1 −1 −1 |
| | 1 −1 1 1 −1 1 −1 −1 1 −1 −1 −1 1 −1 −1 −1 1 −1 −1 −1 1 −1 −1 −1 1 −1 1 1 −1 1 |
| | −1 −1 1 −1 1 1 −1 1 −1 −1 1 −1 −1 −1 1 −1 −1 −1 1 −1 −1 −1 1 −1 −1 −1 1 −1 1 |
| | 1 −1 1 1 1 −1 1 −1 −1 1 −1 −1 −1 1 −1 −1 −1 1 −1 1 1 −1 1 1 1 −1 1 −1 −1 1 −1 |
| | 1 1 −1 1 1 1 −1 1 −1 −1 1 −1 −1 −1 1 −1 −1 −1 1 −1 1 1 −1 1 1 1 −1 1 −1 −1 1 |
| | −1 1 1 −1 1 −1 −1 1 −1 −1 −1 1 −1 1 1 −1 1 −1 −1 1 −1 −1 −1 1 −1 1 1 −1 1 1 1 |
| | −1 1 1 1 −1 1 −1 −1 1 −1 −1 −1 1 −1 1 1 −1 1 −1 −1 1 −1 −1 −1 1 −1 1 1 −1 1 1 |
| | 1 −1 1 1 −1 1 1 1 −1 1 1 1 −1 1 1 1 −1 1 1 1 −1 1 1 −1 1 −1 −1 1 −1 1 1 −1 1 −1 |
| | −1 1 −1 1 1 1 −1 1 1 1 −1 1 1 1 −1 1 1 1 −1 1 1 −1 1 −1 −1 1 −1 1 1 −1 1 −1 −1 1 |
| | −1 1 1 −1 1 −1 −1 1 −1 1 1 −1 1 −1 −1 1 −1 1 1 1 −1 1 1 1 −1 1 1 1 −1 1 1 1 −1 1 |
| | 1 −1 1 −1 −1 1 −1 1 1 −1 1 −1 −1 1 −1 1 1 1 −1 1 1 1 −1 1 1 1 −1 1 1 −1 1 −1 −1 |
| | −1 1 −1 −1 1 −1 1 1 1 −1 1 1 −1 1 −1 −1 1 −1 1 1 1 −1 1 1 −1 1 −1 −1 −1 1 −1 |
| | −1 −1 1 −1 −1 1 −1 1 1 1 −1 1 1 −1 1 −1 −1 1 −1 1 1 1 −1 1 1 −1 1 −1 −1 −1 1 |
| | −1 −1 1 −1 1 1 1 −1 1 1 −1 1 −1 −1 −1 1 −1 −1 −1 1 −1 −1 1 −1 1 1 1 −1 1 1 −1 |
| | 1 −1 −1 1 −1 1 1 1 −1 1 1 −1 1 −1 −1 −1 1 −1 −1 −1 1 −1 −1 1 −1 1 1 1 −1 1 1 1 |
| | −1 −1 −1 1 −1 −1 −1 1 −1 −1 −1 1 −1 −1 −1 −1 1 1 1 1 −1 −1 −1 −1 1 1 1 1 −1 |
| | −1 −1 1 −1 −1 −1 1 −1 −1 −1 1 −1 −1 −1 1 −1 −1 −1 −1 1 1 1 1 −1 −1 −1 −1 1 1 |
| | 1 1 −1 −1 −1 1 −1 −1 −1 −1 1 1 1 1 −1 −1 −1 −1 1 1 1 −1 1 1 1 −1 1 1 1 −1 1 1 1 |
| | −1 1 1 1 1 −1 −1 −1 −1 1 1 1 1 −1 −1 −1 −1 1 1 1 −1 1 1 1 −1 1 1 1 −1 1 1 1 −1 1 |
| | 1 1 −1 1 1 1 −1 1 1 1 1 −1 −1 −1 1 −1 −1 −1 1 −1 −1 −1 −1 1 1 1 −1 1 1 1 1 −1 |
| | −1 −1 −1 1 1 1 −1 1 1 1 1 −1 −1 −1 1 −1 −1 −1 1 −1 −1 −1 −1 1 1 1 −1 1 1 1 1 |
| | −1 −1 −1 −1 1 1 1 1 −1 −1 −1 1 −1 −1 −1 −1 1 1 1 1 −1 −1 −1 1 −1 −1 −1 −1 1 1 |
| | 1 −1 1 1 1 −1 1 1 1 1 −1 −1 −1 1 −1 −1 −1 −1 1 1 1 1 −1 −1 −1 1 −1 −1 −1 −1 1 |
| | 1 1 −1 1 1 1 1 1 1 −1 1 1 1 −1 1 1 1 −1 1 1 1 −1 1 1 1 −1 −1 −1 −1 1 1 1 1 −1 −1 |
| | −1 −1 1 −1 −1 −1 1 −1 −1 −1 1 −1 −1 −1 1 −1 −1 −1 1 −1 −1 −1 1 1 1 1 −1 −1 |
| | −1 −1 1 1 1 1 −1 −1 −1 −1 1 1 1 1 −1 −1 −1 −1 1 1 1 1 −1 −1 −1 −1 1 −1 −1 −1 1 |
| | −1 −1 −1 1 −1 −1 −1 1 1 1 1 −1 −1 −1 −1 1 1 1 1 −1 −1 −1 −1 1 1 1 1 −1 1 1 1 |
| | −1 1 1 1 −1 1 1 1 −1 1 1 1 −1 1 1 1 −1 −1 −1 −1 1 −1 −1 −1 1 1 1 1 −1 −1 −1 −1 |
| | 1 −1 −1 −1 1 1 1 1 −1 −1 −1 −1 1 −1 −1 −1 1 1 1 1 −1 1 1 1 −1 −1 −1 −1 1 1 1 1 |
| | −1 1 1 1 −1 −1 −1 −1 1 −1 −1 −1 1 1 1 1 −1 1 1 1 −1 −1 −1 −1 1 −1 −1 −1 1 −1 |
| | −1 −1 1 1 1 1 −1 1 1 1 −1 1 1 1 −1 −1 −1 −1 1 −1 −1 −1 1 1 1 1 −1 1 1 1 −1 1 1 1 |
| | −1 −1 −1 −1 1 −1 −1 −1 1 1 1 −1 1 1 1 −1 1 1 1 −1 1 1 1 −1 1 −1 −1 1 −1 1 1 −1 |
| | 1 −1 −1 1 −1 1 1 −1 1 −1 −1 1 −1 −1 −1 1 −1 −1 −1 1 −1 −1 −1 1 −1 1 1 −1 1 −1 |
| | −1 1 −1 1 1 −1 1 −1 −1 1 −1 −1 −1 1 −1 1 1 −1 1 −1 −1 1 −1 1 1 −1 1 1 1 −1 1 1 |
| | 1 −1 1 1 1 −1 1 1 1 −1 1 1 1 −1 1 −1 −1 1 −1 1 1 −1 1 −1 −1 1 −1 −1 −1 1 −1 −1 |
| | −1 1 −1 −1 −1 1 −1 −1 −1 1 −1 1 1 −1 1 1 1 −1 1 −1 −1 1 −1 −1 −1 1 −1 −1 −1 1 |
| | −1 1 1 −1 1 1 1 1 −1 −1 1 −1 −1 −1 1 −1 −1 −1 1 −1 1 1 −1 1 1 1 −1 1 1 1 −1 |
| | 1 −1 −1 1 −1 −1 −1 1 −1 1 1 −1 1 −1 −1 1 −1 1 1 −1 1 1 1 −1 1 −1 −1 1 −1 1 1 |
| | −1 1 1 1 −1 1 −1 −1 1 −1 −1 −1 1 −1 1 1 −1 1 −1 −1 1 −1 −1 −1 1 −1 1 1 −1 1 −1 |
| | −1 1 −1 −1 −1 1 −1 1 1 −1 1 1 1 −1 1 1 −1 1 1 1 −1 1 1 1 −1 1 1 1 −1 1 1 1 −1 1 |
| | 1 −1 1 −1 −1 1 −1 1 1 −1 1 −1 −1 −1 1 −1 −1 −1 1 −1 −1 −1 1 −1 −1 −1 1 −1 −1 |
| | −1 1 −1 −1 1 −1 1 1 −1 1 −1 −1 1 −1 1 1 −1 1 −1 −1 1 −1 1 1 −1 1 −1 −1 1 −1 1 |
| | 1 −1 1 −1 −1 −1 1 −1 −1 −1 1 −1 −1 −1 1 −1 −1 1 −1 1 1 −1 1 −1 −1 1 −1 1 1 −1 |
| | 1 −1 −1 1 −1 1 1 1 −1 1 1 1 −1 1 1 1 −1 1 1 −1 1 −1 −1 −1 1 −1 −1 1 −1 1 1 1 −1 |
| | 1 1 −1 1 −1 −1 1 −1 1 1 1 −1 1 1 −1 1 −1 −1 1 −1 1 1 1 −1 1 1 −1 1 −1 −1 −1 1 |
| | −1 −1 1 −1 1 1 −1 1 −1 −1 −1 1 −1 −1 1 −1 1 1 1 −1 1 1 −1 1 −1 −1 −1 1 −1 −1 1 |
| | −1 1 1 1 −1 1 1 1 −1 1 1 −1 1 −1 −1 −1 1 −1 −1 −1 1 −1 −1 1 −1 1 1 1 −1 1 1 −1 |
| | 1 −1 −1 −1 1 −1 −1 −1 1 −1 −1 1 −1 1 1 1 −1 1 1 1 −1 −1 −1 1 −1 −1 −1 1 −1 −1 |
| | −1 1 −1 −1 −1 −1 1 1 1 1 −1 −1 −1 −1 1 1 1 1 −1 −1 −1 −1 1 1 1 −1 1 1 1 −1 1 1 |
| | 1 −1 1 1 1 1 −1 −1 −1 −1 1 1 1 1 −1 −1 −1 −1 1 1 1 −1 1 1 1 1 −1 −1 −1 −1 1 1 1 |
| | 1 −1 −1 −1 1 −1 −1 −1 1 −1 −1 −1 1 −1 −1 −1 1 −1 −1 −1 1 −1 −1 −1 −1 1 1 1 1 |
| | −1 −1 −1 −1 1 1 1 −1 1 1 1 −1 1 1 1 −1 1 1 1 −1 1 1 1 −1 1 1 1 −1 1 1 1 1 −1 −1 |
| | −1 1 −1 −1 −1 1 −1 −1 −1 −1 1 1 1 −1 1 1 1 1 −1 −1 −1 1 −1 −1 −1 1 −1 −1 −1 |
| | −1 1 1 1 −1 1 1 1 −1 1 1 1 1 −1 −1 −1 1 −1 −1 −1 −1 1 1 1 1 −1 −1 −1 −1 1 1 1 |
| | −1 1 1 1 1 −1 −1 −1 −1 1 1 1 −1 1 1 1 1 −1 −1 −1 1 −1 −1 −1 −1 1 1 1 1 −1 −1 |
| | −1 1 −1 −1 −1 −1 1 1 1 1 −1 −1 −1 1 −1 −1 −1 −1 1 1 1 −1 1 1 1 1 1 1 −1 1 1 1 |
| | −1 1 1 1 −1 1 1 1 −1 1 1 1 −1 −1 −1 −1 1 1 1 1 −1 −1 −1 −1 1 −1 −1 −1 1 −1 −1 |
| | −1 1 −1 −1 −1 1 −1 −1 −1 1 −1 −1 −1 1 1 1 1 −1 −1 −1 −1 1 1 1 1 −1 1 1 1 −1 −1 |
| | −1 −1 1 1 1 1 −1 −1 −1 −1 1 1 1 1 −1 1 1 1 −1 1 1 1 −1 1 1 1 −1 −1 −1 −1 1 1 1 1 |
| | −1 −1 −1 −1 1 1 1 1 −1 −1 −1 −1 1 −1 −1 −1 1 −1 −1 −1 1 −1 −1 −1 1 1 1 1 −1 1 |
| | 1 1 −1 −1 −1 −1 1 −1 −1 −1 1 1 1 1 −1 −1 −1 −1 1 −1 −1 −1 1 1 1 1 −1 −1 −1 −1 |
| | 1 −1 −1 −1 1 1 1 1 −1 1 1 1 −1 −1 −1 −1 1 1 1 1 −1 1 1 1 −1 −1 −1 −1 1 1 1 1 −1 |
| | −1 −1 −1 1 −1 −1 −1 1 1 1 1 −1 1 1 1 −1 1 1 1 −1 −1 −1 −1 1 −1 −1 −1 1 −1 −1 |
| | −1 1 1 1 1 −1 1 1 1 −1 −1 −1 −1 1 −1 −1 −1 1 −1 −1 −1 1 1 1 1 −1 1 1 1 −1 1 1 |
| | −1 1 1 1 −1 1 1 1 −1 1 1 1 −1 1 −1 −1 1 −1 1 1 −1 1 −1 −1 1 −1 1 1 −1 1 −1 −1 1 |
| | −1 −1 −1 1 −1 −1 −1 1 −1 −1 −1 1 −1 1 1 −1 1 −1 −1 1 −1 1 1 −1 1 −1 −1 1 −1 1 |
| | 1 −1 1 −1 −1 1 −1 1 1 −1 1 −1 −1 1 −1 −1 −1 1 −1 −1 −1 1 −1 −1 −1 1 −1 −1 −1 |
| | 1 −1 −1 −1 1 −1 1 1 −1 1 −1 −1 1 −1 1 1 −1 1 1 1 −1 1 1 1 −1 1 1 1 −1 1 1 1 −1 1 |
| | 1 1 −1 1 1 1 −1 1 −1 −1 1 −1 −1 −1 1 −1 −1 −1 1 −1 1 1 −1 1 1 1 −1 1 −1 −1 1 |
| | −1 −1 −1 1 −1 −1 −1 1 −1 1 1 −1 1 1 1 −1 1 1 1 −1 1 −1 −1 1 −1 −1 −1 1 −1 1 1 |
| | −1 1 1 1 −1 1 −1 −1 1 −1 −1 −1 1 −1 1 1 −1 1 −1 −1 1 −1 −1 −1 1 −1 1 1 −1 1 1 |
| | 1 −1 1 −1 −1 1 −1 1 1 −1 1 1 1 −1 1 −1 −1 1 −1 1 1 −1 1 1 1 −1 1 −1 −1 1 −1 −1 |
| | −1 1 −1 1 −1 1 1 1 −1 1 1 1 −1 1 1 1 −1 1 1 1 −1 1 1 −1 1 −1 −1 1 −1 1 1 −1 1 −1 |
| | −1 −1 1 −1 −1 −1 1 −1 −1 −1 1 −1 −1 −1 1 −1 −1 −1 1 −1 −1 1 −1 1 1 −1 1 −1 |
| | −1 1 −1 1 1 1 −1 1 1 −1 1 −1 −1 1 −1 1 1 −1 1 −1 −1 1 −1 1 1 1 −1 1 1 1 −1 1 1 1 |
| | −1 1 1 −1 1 −1 −1 1 −1 1 1 −1 1 −1 −1 1 −1 1 1 −1 1 −1 −1 −1 1 −1 −1 −1 1 −1 |
| | −1 −1 1 −1 −1 −1 1 −1 −1 −1 1 −1 −1 1 −1 1 1 1 −1 1 1 −1 1 −1 −1 1 −1 1 1 1 −1 |
| | 1 1 −1 1 −1 −1 1 −1 1 1 1 −1 1 1 −1 1 −1 −1 −1 1 −1 −1 1 −1 1 1 −1 1 −1 −1 −1 |
| | 1 −1 −1 1 −1 1 1 −1 1 −1 −1 1 −1 1 1 1 −1 1 1 −1 1 −1 −1 −1 1 −1 −1 −1 1 −1 −1 |
| | 1 −1 1 1 1 −1 1 1 1 −1 1 1 −1 1 −1 −1 −1 1 −1 −1 1 −1 1 1 1 −1 1 1 1 −1 1 1 −1 1 |
| | −1 −1 −1 1 −1 −1 1 −1 −1 −1 1 −1 −1 −1 1 −1 −1 −1 1 −1 −1 −1 −1 1 1 1 1 −1 |
| | −1 −1 −1 1 1 1 1 −1 −1 −1 −1 1 1 1 −1 1 1 1 −1 1 1 1 −1 1 1 1 1 −1 −1 −1 −1 1 1 |
| | 1 1 −1 −1 −1 −1 1 1 1 1 −1 −1 −1 −1 1 1 1 1 −1 −1 −1 −1 1 1 1 −1 1 1 1 −1 1 1 1 |
| | −1 1 1 1 −1 1 1 1 −1 1 1 1 1 −1 −1 −1 −1 1 1 1 1 −1 −1 −1 1 −1 −1 −1 1 −1 −1 |
| | −1 1 −1 −1 −1 1 −1 −1 −1 −1 1 1 1 −1 1 1 1 1 −1 −1 −1 1 −1 −1 −1 1 −1 −1 −1 |
| | −1 1 1 1 −1 1 1 1 1 −1 −1 −1 1 −1 −1 −1 1 −1 −1 −1 −1 1 1 1 −1 1 1 1 −1 1 1 1 1 |
| | −1 −1 −1 1 −1 −1 −1 −1 1 1 1 −1 1 1 1 1 −1 −1 −1 1 −1 −1 −1 −1 1 1 1 1 −1 −1 |
| | −1 1 −1 −1 −1 −1 1 1 1 −1 1 1 1 1 −1 −1 −1 −1 1 1 1 −1 1 1 1 1 −1 −1 −1 −1 1 1 |
| | 1 −1 1 1 1 1 −1 −1 −1 1 −1 −1 −1 1 1 1 −1 1 1 1 −1 1 1 1 −1 1 1 1 −1 1 1 1 −1 −1 |
| | −1 −1 1 1 1 1 −1 −1 −1 −1 1 1 1 1 −1 1 1 1 −1 1 1 1 −1 1 1 1 −1 1 1 1 −1 −1 −1 |
| | −1 1 1 1 1 −1 −1 −1 −1 1 −1 −1 −1 1 1 1 1 −1 −1 −1 −1 1 1 1 1 −1 −1 −1 −1 1 −1 |
| | −1 −1 1 −1 −1 −1 1 −1 −1 −1 1 −1 −1 −1 1 1 1 1 −1 −1 −1 −1 1 1 1 1 −1 −1 −1 |
| | −1 1 −1 −1 −1 1 −1 −1 −1 1 −1 −1 −1 1 1 1 1 −1 1 1 1 −1 −1 −1 −1 1 −1 −1 −1 1 |
| | 1 1 1 −1 −1 −1 −1 1 −1 −1 −1 1 1 1 1 −1 1 1 1 −1 1 1 1 −1 −1 −1 −1 1 −1 −1 −1 |
| | 1 1 1 1 −1 −1 −1 −1 1 −1 −1 −1 1 1 1 1 −1 −1 −1 −1 1 1 1 1 −1 1 1 1 −1 −1 −1 |
| | −1 1 −1 −1 −1 1 −1 −1 −1 1 1 1 1 −1 1 1 1 −1 −1 −1 −1 1 1 1 1 −1 1 1 1 −1 −1 |
| | −1 −1 1 −1 −1 −1 1 −1 −1 −1 1 1 1 1 −1 1 1 1 −1 1 1 −1 1 1 1 −1 1 1 1 −1 1 1 1 |
| | −1 1 −1 −1 1 −1 1 1 −1 1 −1 −1 1 −1 1 1 −1 1 1 1 −1 1 1 1 −1 1 1 1 −1 1 1 1 −1 1 |
| | −1 −1 1 −1 1 1 −1 1 −1 −1 1 −1 1 1 −1 1 −1 −1 1 −1 1 1 −1 1 −1 −1 1 −1 1 1 −1 |
| | 1 1 1 −1 1 1 1 −1 1 1 1 −1 1 1 1 −1 1 −1 −1 1 −1 1 1 −1 1 −1 −1 1 −1 1 1 −1 1 1 |
| | 1 −1 1 1 1 −1 1 1 1 −1 1 1 1 −1 1 1 1 −1 1 1 1 −1 1 −1 −1 1 −1 −1 −1 1 −1 −1 −1 |
| | 1 −1 1 1 −1 1 1 1 −1 1 −1 −1 1 −1 1 1 −1 1 1 1 −1 1 −1 −1 1 −1 −1 −1 1 −1 −1 |
| | −1 1 −1 1 1 −1 1 1 1 −1 1 −1 −1 1 −1 −1 −1 1 −1 1 1 −1 1 1 1 −1 1 −1 −1 1 −1 1 |
| | 1 −1 1 1 1 −1 1 −1 −1 1 −1 −1 −1 1 −1 −1 −1 1 −1 1 1 −1 1 1 1 −1 1 −1 −1 1 −1 |
| | 1 1 −1 1 1 1 −1 1 −1 −1 1 −1 −1 −1 1 −1 1 −1 1 1 1 −1 1 1 1 −1 1 1 1 −1 1 1 1 −1 |
| | 1 1 −1 1 −1 −1 1 −1 1 1 −1 1 −1 −1 1 −1 1 1 1 −1 1 1 1 −1 1 1 1 −1 1 1 1 −1 1 1 |
| | −1 1 −1 −1 1 −1 1 1 −1 1 −1 −1 −1 1 −1 −1 1 −1 1 1 −1 1 −1 −1 1 −1 1 1 −1 1 −1 |
| | −1 −1 1 −1 −1 −1 1 −1 −1 −1 1 −1 −1 −1 1 −1 −1 1 −1 1 1 −1 1 −1 −1 1 −1 1 1 |
| | −1 1 −1 −1 −1 1 −1 −1 −1 1 −1 −1 −1 1 −1 −1 −1 1 −1 −1 −1 1 −1 −1 1 −1 1 1 1 |
| | −1 1 1 −1 1 −1 1 −1 1 1 1 −1 1 1 −1 1 −1 −1 −1 1 −1 −1 −1 1 −1 −1 1 −1 1 1 |
| | 1 −1 1 1 −1 1 −1 −1 1 −1 1 1 1 −1 1 1 −1 1 −1 −1 1 −1 1 1 −1 1 −1 −1 −1 1 −1 |
| | −1 1 −1 1 1 1 −1 1 1 1 −1 1 1 −1 1 −1 −1 −1 1 −1 −1 1 −1 1 1 −1 1 −1 −1 −1 1 |
| | −1 −1 1 −1 1 1 1 −1 1 1 1 −1 1 1 −1 1 −1 −1 −1 1 −1 −1 1 −1 −1 −1 1 −1 −1 −1 1 |
| | −1 −1 −1 1 −1 −1 −1 −1 1 1 1 1 −1 −1 −1 −1 1 1 1 1 −1 −1 −1 1 −1 −1 −1 1 −1 |
| | −1 −1 1 −1 −1 −1 1 −1 −1 −1 −1 1 1 1 1 −1 −1 −1 −1 1 1 1 1 −1 −1 −1 −1 1 1 1 1 |
| | −1 −1 −1 −1 1 1 1 1 −1 −1 −1 1 −1 −1 −1 1 −1 −1 −1 1 −1 −1 −1 1 −1 −1 −1 −1 |
| | 1 1 1 1 −1 −1 −1 −1 1 1 1 1 −1 −1 −1 1 −1 −1 −1 1 −1 −1 −1 1 −1 −1 −1 1 −1 −1 |
| | −1 −1 1 1 1 −1 1 1 1 1 −1 −1 −1 1 −1 −1 −1 1 −1 −1 −1 −1 1 1 1 −1 1 1 1 1 −1 |
| | −1 −1 −1 1 1 1 −1 1 1 1 1 −1 −1 −1 1 −1 −1 −1 1 −1 −1 −1 −1 1 1 1 −1 1 1 1 1 |
| | −1 −1 −1 1 −1 −1 −1 −1 1 1 1 −1 1 1 1 1 −1 −1 −1 −1 1 1 1 −1 1 1 1 1 −1 −1 −1 |
| | 1 −1 −1 −1 1 −1 −1 −1 −1 1 1 1 −1 1 1 1 1 −1 −1 −1 −1 1 1 1 −1 1 1 1 1 −1 −1 |
| | −1 1 −1 −1 −1 −1 −1 −1 1 −1 −1 −1 1 −1 −1 −1 1 −1 −1 −1 1 −1 −1 −1 1 1 1 1 |
| | −1 −1 −1 −1 1 1 1 1 −1 −1 −1 −1 1 −1 −1 −1 1 −1 −1 −1 1 −1 −1 −1 1 −1 −1 −1 |
| | 1 1 1 1 −1 −1 −1 −1 1 1 1 1 −1 −1 −1 −1 1 1 1 1 −1 −1 −1 −1 1 1 1 1 −1 −1 −1 |
| | −1 1 −1 −1 −1 1 −1 −1 −1 1 −1 −1 −1 1 −1 −1 −1 1 1 1 1 −1 −1 −1 −1 1 1 1 1 −1 |
| | −1 −1 −1 1 −1 −1 −1 1 −1 −1 −1 1 −1 −1 −1 1 −1 −1 −1 1 −1 −1 −1 1 1 1 1 −1 1 |
| | 1 1 −1 −1 −1 −1 1 1 1 1 −1 1 1 1 −1 −1 −1 −1 1 −1 −1 −1 1 −1 −1 −1 1 1 1 1 −1 |
| | 1 1 1 −1 −1 −1 −1 1 1 1 1 −1 1 1 1 −1 −1 −1 −1 1 −1 −1 −1 1 1 1 1 −1 1 1 1 −1 |
| | −1 −1 −1 1 −1 −1 −1 1 −1 −1 −1 1 1 1 1 −1 1 1 1 −1 −1 −1 −1 1 1 1 1 −1 1 1 1 |
| | −1 −1 −1 −1 1 −1 −1 −1 1 −1 −1 −1 1 1 1 1 −1 1 1 1 −1 −1 −1 1 −1 −1 −1 1 −1 |
| | −1 −1 1 −1 −1 −1 1 −1 1 1 −1 1 −1 −1 1 −1 1 1 −1 1 −1 −1 1 −1 −1 −1 1 −1 −1 |
| | −1 1 −1 −1 −1 1 −1 −1 −1 1 −1 1 1 −1 1 −1 −1 1 −1 1 1 −1 1 −1 −1 1 −1 −1 −1 1 |
| | −1 1 1 −1 1 −1 −1 1 −1 1 1 −1 1 1 1 −1 1 1 1 −1 1 1 1 −1 1 1 1 −1 1 −1 −1 1 −1 1 |
| | 1 −1 1 −1 −1 1 −1 1 1 −1 1 1 1 −1 1 1 1 −1 1 1 1 −1 1 1 1 −1 1 −1 −1 1 −1 −1 −1 |
| | 1 −1 1 1 −1 1 1 1 −1 1 1 1 −1 1 −1 −1 1 −1 −1 −1 1 −1 1 1 −1 1 −1 −1 1 −1 −1 |
| | −1 1 −1 1 1 −1 1 1 1 −1 1 1 1 −1 1 −1 −1 1 −1 −1 −1 1 −1 1 1 −1 1 −1 −1 1 −1 1 |
| | 1 −1 1 1 1 −1 1 −1 −1 1 −1 1 1 −1 1 1 1 −1 1 −1 −1 1 −1 −1 −1 1 −1 −1 −1 1 −1 |
| | 1 1 −1 1 1 1 −1 1 −1 −1 1 −1 1 1 −1 1 1 1 −1 1 −1 −1 1 −1 −1 −1 1 −1 −1 1 −1 |
| | −1 −1 1 −1 −1 −1 1 −1 −1 −1 1 −1 −1 −1 1 −1 −1 1 −1 1 1 −1 1 −1 −1 1 −1 1 1 |
| | −1 1 −1 −1 −1 1 −1 −1 −1 1 −1 −1 −1 1 −1 −1 −1 1 −1 −1 1 −1 1 1 −1 1 −1 −1 1 |
| | −1 1 1 −1 1 −1 −1 1 −1 1 1 −1 1 −1 −1 1 −1 1 1 −1 1 −1 −1 −1 1 −1 −1 −1 1 −1 |
| | −1 −1 1 −1 −1 −1 1 −1 −1 1 −1 1 1 −1 1 −1 −1 1 −1 1 1 −1 1 −1 −1 −1 1 −1 −1 |
| | −1 1 −1 −1 −1 1 −1 −1 1 −1 1 1 1 −1 1 1 −1 1 −1 −1 −1 1 −1 −1 1 −1 1 1 −1 1 −1 |
| | −1 −1 1 −1 −1 1 −1 1 1 1 −1 1 1 1 −1 1 1 −1 1 −1 −1 −1 1 −1 −1 1 −1 1 1 −1 1 |
| | −1 −1 −1 1 −1 −1 1 −1 1 1 1 −1 1 1 −1 1 −1 −1 −1 1 −1 −1 1 −1 1 1 1 −1 1 1 1 |
| | −1 1 1 −1 1 −1 −1 −1 1 −1 −1 1 −1 1 1 −1 1 −1 −1 −1 1 −1 −1 1 −1 1 1 1 −1 1 1 |
| | 1 −1 1 1 −1 1 −1 −1 −1 1 −1 −1 −1 1 1 1 −1 1 1 1 −1 1 1 1 −1 1 1 1 1 −1 −1 −1 |
| | −1 1 1 1 1 −1 −1 −1 −1 1 1 1 −1 1 1 1 −1 1 1 1 −1 1 1 1 −1 1 1 1 1 −1 −1 −1 −1 1 |
| | 1 1 1 −1 −1 −1 −1 1 1 1 −1 1 1 1 1 −1 −1 −1 −1 1 1 1 1 −1 −1 −1 1 −1 −1 −1 1 |
| | −1 −1 −1 1 −1 −1 −1 1 −1 −1 −1 −1 1 1 1 1 −1 −1 −1 −1 1 1 1 1 −1 −1 −1 1 −1 |
| | −1 −1 1 −1 −1 −1 1 −1 −1 −1 1 −1 −1 −1 1 −1 −1 −1 1 −1 −1 −1 −1 1 1 1 −1 1 1 |
| | 1 −1 1 1 1 1 −1 −1 −1 1 −1 −1 −1 −1 1 1 1 1 −1 −1 −1 1 −1 −1 −1 −1 1 1 1 −1 1 |
| | 1 1 −1 1 1 1 1 −1 −1 −1 1 −1 −1 −1 −1 1 1 1 1 −1 −1 −1 −1 1 1 1 −1 1 1 1 1 −1 |
| | −1 −1 −1 1 1 1 −1 1 1 1 1 −1 −1 −1 1 −1 −1 −1 1 −1 −1 −1 −1 1 1 1 −1 1 1 1 1 |
| | −1 −1 −1 −1 1 1 1 −1 1 1 1 1 −1 −1 −1 1 −1 −1 −1 −1 −1 −1 1 −1 −1 −1 1 −1 −1 |
| | −1 1 −1 −1 −1 1 −1 −1 −1 1 1 1 1 −1 −1 −1 −1 1 1 1 1 −1 1 1 1 −1 1 1 1 −1 1 1 1 |
| | −1 1 1 1 −1 1 1 1 −1 −1 −1 −1 1 1 1 1 −1 −1 −1 −1 1 1 1 1 −1 −1 −1 −1 1 1 1 1 |
| | −1 −1 −1 −1 1 1 1 1 −1 1 1 1 −1 1 1 1 −1 1 1 1 −1 −1 −1 −1 1 1 1 1 −1 −1 −1 −1 |
| | 1 1 1 1 −1 −1 −1 −1 1 −1 −1 −1 1 −1 −1 −1 1 −1 −1 −1 1 −1 −1 −1 1 −1 −1 −1 1 |
| | 1 1 1 −1 1 1 1 −1 −1 −1 −1 1 1 1 1 −1 1 1 1 −1 −1 −1 −1 1 1 1 1 −1 1 1 1 −1 −1 |
| | −1 −1 1 −1 −1 −1 1 1 1 1 −1 −1 −1 −1 1 −1 −1 −1 1 1 1 1 −1 1 1 1 −1 −1 −1 −1 1 |
| | −1 −1 −1 1 1 1 1 −1 1 1 1 −1 1 1 1 −1 −1 −1 −1 1 −1 −1 −1 1 −1 −1 −1 1 1 1 1 |
| | −1 1 1 1 −1 −1 −1 −1 1 −1 −1 −1 1 −1 −1 −1 1 1 1 1 −1 1 1 1 −1 −1 −1 1 −1 −1 |
| | −1 1 −1 −1 −1 1 −1 −1 −1 1 −1 1 1 −1 1 −1 −1 1 −1 1 1 −1 1 −1 −1 1 −1 1 1 −1 1 |
| | 1 1 −1 1 1 1 −1 1 1 1 −1 1 −1 −1 1 −1 1 1 −1 1 −1 −1 1 −1 1 1 −1 1 1 1 −1 1 −1 |
| | −1 1 −1 1 1 −1 1 −1 −1 1 −1 −1 −1 1 −1 −1 −1 1 −1 −1 −1 1 −1 −1 −1 1 −1 −1 |
| | −1 1 −1 1 1 −1 1 −1 −1 1 −1 1 1 −1 1 1 1 −1 1 1 1 −1 1 1 1 −1 1 1 1 −1 1 −1 −1 1 |
| | −1 −1 −1 1 −1 1 1 −1 1 1 1 −1 1 1 1 −1 1 −1 −1 1 −1 −1 −1 1 −1 1 1 −1 1 1 1 −1 |
| | 1 1 1 −1 1 −1 −1 1 −1 −1 −1 1 −1 −1 −1 1 −1 1 1 −1 1 1 1 −1 1 −1 −1 1 −1 1 1 |
| | −1 1 −1 −1 1 −1 −1 −1 1 −1 1 1 −1 1 −1 −1 1 −1 −1 −1 1 −1 1 1 −1 1 1 1 −1 1 −1 |
| | −1 1 −1 1 1 −1 1 1 1 −1 1 −1 −1 1 −1 1 1 −1 1 1 1 −1 1 −1 −1 1 −1 −1 −1 1 −1 |
| | −1 1 −1 −1 −1 1 −1 −1 −1 1 −1 −1 −1 1 −1 −1 −1 1 −1 −1 1 −1 1 1 −1 1 −1 −1 1 |
| | −1 1 1 1 −1 1 1 1 −1 1 1 1 −1 1 1 1 −1 1 1 1 −1 1 1 −1 1 −1 −1 1 −1 1 1 −1 1 −1 |
| | −1 1 −1 1 1 −1 1 −1 −1 1 −1 1 1 −1 1 −1 −1 1 −1 1 1 1 −1 1 1 1 −1 1 1 1 −1 1 1 |
| | −1 1 −1 −1 1 −1 1 1 −1 1 −1 −1 1 −1 1 1 −1 1 −1 −1 −1 1 −1 −1 −1 1 −1 −1 −1 1 |
| | −1 −1 1 −1 1 1 1 −1 1 1 −1 1 −1 −1 −1 1 −1 −1 1 −1 1 1 −1 1 −1 −1 −1 1 −1 −1 1 |
| | −1 1 1 −1 1 −1 −1 −1 1 −1 −1 1 −1 1 1 1 −1 1 1 −1 1 −1 −1 1 −1 1 1 1 −1 1 1 −1 |
| | 1 −1 −1 −1 1 −1 −1 1 −1 1 1 1 −1 1 1 −1 1 −1 −1 −1 1 −1 −1 −1 1 −1 −1 1 −1 1 1 |
| | 1 −1 1 1 1 −1 1 1 −1 1 −1 −1 −1 1 −1 −1 1 −1 1 1 1 −1 1 1 1 −1 1 1 −1 1 −1 −1 |
| | −1 1 −1 −1 −1 1 1 1 −1 1 1 1 −1 1 1 1 −1 1 1 1 1 −1 −1 −1 −1 1 1 1 1 −1 −1 −1 |
| | −1 1 1 1 1 −1 −1 −1 1 −1 −1 −1 1 −1 −1 −1 1 −1 −1 −1 −1 1 1 1 1 −1 −1 −1 −1 1 |
| | 1 1 1 −1 −1 −1 1 −1 −1 −1 −1 1 1 1 1 −1 −1 −1 −1 1 1 1 −1 1 1 1 −1 1 1 1 −1 1 1 |
| | 1 −1 1 1 1 −1 1 1 1 1 −1 −1 −1 −1 1 1 1 1 −1 −1 −1 1 −1 −1 −1 1 −1 −1 −1 1 −1 |
| | −1 −1 1 −1 −1 −1 1 −1 −1 −1 1 −1 −1 −1 −1 1 1 1 −1 1 1 1 −1 1 1 1 1 −1 −1 −1 1 |
| | −1 −1 −1 −1 1 1 1 −1 1 1 1 −1 1 1 1 1 −1 −1 −1 1 −1 −1 −1 1 −1 −1 −1 −1 1 1 1 |
| | −1 1 1 1 1 −1 −1 −1 −1 1 1 1 1 −1 −1 −1 1 −1 −1 −1 −1 1 1 1 1 −1 −1 −1 1 −1 −1 |
| | −1 −1 1 1 1 −1 1 1 1 1 −1 −1 −1 −1 1 1 1 −1 1 1 1 1 −1 −1 −1 −1 1 1 1 −1 1 1 1 1 |
| | −1 −1 −1 1 −1 −1 −1 1 1 1 −1 1 1 1 −1 1 1 1 −1 1 1 1 −1 1 1 1 −1 −1 −1 −1 1 1 1 |
| | 1 −1 −1 −1 −1 1 −1 −1 −1 1 −1 −1 −1 1 −1 −1 −1 1 −1 −1 −1 1 −1 −1 −1 1 1 1 1 |
| | −1 −1 −1 −1 1 1 1 1 −1 1 1 1 −1 −1 −1 −1 1 1 1 1 −1 −1 −1 −1 1 1 1 1 −1 1 1 1 |
| | −1 1 1 1 −1 1 1 1 −1 −1 −1 −1 1 1 1 1 −1 −1 −1 −1 1 1 1 1 −1 −1 −1 −1 1 −1 −1 |
| | −1 1 −1 −1 −1 1 −1 −1 −1 1 1 1 1 −1 1 1 1 −1 −1 −1 −1 1 −1 −1 −1 1 1 1 1 −1 −1 |
| | −1 −1 1 −1 −1 −1 1 1 1 1 −1 −1 −1 −1 1 −1 −1 −1 1 1 1 1 −1 1 1 1 −1 −1 −1 −1 1 |
| | 1 1 1 −1 1 1 1 −1 −1 −1 −1 1 1 1 1 −1 −1 −1 −1 1 −1 −1 −1 1 1 1 1 −1 1 1 1 −1 1 |
| | 1 1 −1 −1 −1 −1 1 −1 −1 −1 1 −1 −1 −1 1 1 1 1 −1 1 1 1 −1 −1 −1 −1 1 −1 −1 −1 |
| | 1 −1 −1 −1 1 1 1 1 −1 1 1 1 −1 1 1 −1 1 1 1 −1 1 1 1 −1 1 1 1 −1 1 −1 −1 1 −1 1 |
| | 1 −1 1 −1 −1 1 −1 1 1 −1 1 −1 −1 1 −1 −1 −1 1 −1 −1 −1 1 −1 −1 −1 1 −1 1 1 −1 |
| | 1 −1 −1 1 −1 1 1 −1 1 −1 −1 1 −1 1 1 −1 1 −1 −1 1 −1 1 1 −1 1 −1 −1 1 −1 −1 −1 |
| | 1 −1 −1 −1 1 −1 −1 −1 1 −1 −1 −1 1 −1 −1 −1 1 −1 1 1 −1 1 −1 −1 1 −1 1 1 −1 1 |
| | 1 1 −1 1 1 1 −1 1 1 1 −1 1 1 1 −1 1 1 1 −1 1 1 1 −1 1 −1 −1 1 −1 −1 −1 1 −1 −1 |
| | −1 1 −1 1 1 −1 1 1 1 −1 1 −1 −1 1 −1 −1 −1 1 −1 −1 −1 1 −1 1 1 −1 1 1 1 −1 1 1 |
| | 1 −1 1 −1 −1 1 −1 −1 −1 1 −1 1 1 −1 1 1 1 −1 1 −1 −1 1 −1 −1 −1 1 −1 1 1 −1 1 |
| | −1 −1 1 −1 −1 −1 1 −1 1 1 −1 1 1 1 −1 1 −1 −1 1 −1 1 1 −1 1 1 1 −1 1 −1 −1 1 |
| | −1 1 1 −1 1 1 1 −1 1 −1 −1 1 −1 −1 −1 1 −1 1 −1 1 1 1 −1 1 1 1 −1 1 1 1 −1 1 1 1 |
| | −1 1 1 −1 1 −1 −1 1 −1 1 1 −1 1 −1 −1 −1 1 −1 −1 −1 1 −1 −1 −1 1 −1 −1 −1 1 |
| | −1 −1 −1 1 −1 −1 1 −1 1 1 −1 1 −1 −1 1 −1 1 1 1 −1 1 1 −1 1 −1 −1 1 −1 1 1 −1 |
| | 1 −1 −1 1 −1 1 1 1 −1 1 1 1 −1 1 1 1 −1 1 1 −1 1 −1 −1 1 −1 1 1 −1 1 −1 −1 1 −1 |
| | 1 1 −1 1 −1 −1 −1 1 −1 −1 −1 1 −1 −1 −1 1 −1 −1 −1 1 −1 −1 −1 1 −1 −1 1 −1 1 |
| | 1 1 −1 1 1 −1 1 −1 −1 1 −1 1 1 1 −1 1 1 −1 1 −1 −1 1 −1 1 1 1 −1 1 1 −1 1 −1 −1 |
| | −1 1 −1 −1 1 −1 1 1 −1 1 −1 −1 −1 1 −1 −1 1 −1 1 1 −1 1 −1 −1 1 −1 1 1 1 −1 1 |
| | 1 −1 1 −1 −1 −1 1 −1 −1 −1 1 −1 −1 1 −1 1 1 1 −1 1 1 1 −1 1 1 −1 1 −1 −1 −1 1 |
| | −1 −1 1 −1 1 1 1 −1 1 1 1 −1 1 1 −1 1 −1 −1 −1 1 −1 −1 1 −1 −1 −1 1 −1 −1 −1 1 |
| | −1 −1 −1 1 −1 −1 −1 −1 1 1 1 1 −1 −1 −1 −1 1 1 1 1 −1 −1 −1 −1 1 1 1 −1 1 1 1 |
| | −1 1 1 1 −1 1 1 1 1 −1 −1 −1 −1 1 1 1 1 −1 −1 −1 −1 1 1 1 1 −1 −1 −1 −1 1 1 1 1 |
| | −1 −1 −1 −1 1 1 1 −1 1 1 1 −1 1 1 1 −1 1 1 1 −1 1 1 1 −1 1 1 1 1 −1 −1 −1 −1 1 1 |
| | 1 1 −1 −1 −1 1 −1 −1 −1 1 −1 −1 −1 1 −1 −1 −1 1 −1 −1 −1 −1 1 1 1 −1 1 1 1 1 |
| | −1 −1 −1 1 −1 −1 −1 1 −1 −1 −1 −1 1 1 1 −1 1 1 1 1 −1 −1 −1 1 −1 −1 −1 1 −1 |
| | −1 −1 −1 1 1 1 −1 1 1 1 −1 1 1 1 1 −1 −1 −1 1 −1 −1 −1 −1 1 1 1 −1 1 1 1 1 −1 |
| | −1 −1 1 −1 −1 −1 −1 1 1 1 1 −1 −1 −1 1 −1 −1 −1 −1 1 1 1 −1 1 1 1 1 −1 −1 −1 |
| | −1 1 1 1 −1 1 1 1 1 −1 −1 −1 −1 1 1 1 −1 1 1 1 1 −1 −1 −1 1 −1 −1 −1 1 1 1 −1 1 |
| | 1 1 −1 1 1 1 −1 1 1 1 −1 1 1 1 −1 −1 −1 −1 1 1 1 1 −1 −1 −1 −1 1 1 1 1 −1 1 1 1 |
| | −1 1 1 1 −1 1 1 1 −1 1 1 1 −1 −1 −1 −1 1 1 1 1 −1 −1 −1 −1 1 −1 −1 −1 1 1 1 1 |
| | −1 −1 −1 −1 1 1 1 1 −1 −1 −1 −1 1 −1 −1 −1 1 −1 −1 −1 1 −1 −1 −1 1 −1 −1 −1 |
| | 1 1 1 1 −1 −1 −1 −1 1 1 1 1 −1 −1 −1 −1 1 −1 −1 −1 1 −1 −1 −1 1 −1 −1 −1 1 1 1 |
| | 1 −1 1 1 1 −1 −1 −1 −1 1 −1 −1 −1 1 1 1 1 −1 −1 −1 −1 1 −1 −1 −1 1 1 1 1 −1 1 |
| | 1 1 −1 1 1 1 −1 −1 −1 −1 1 −1 −1 −1 1 1 1 1 −1 −1 −1 −1 1 −1 −1 −1 1 1 1 1 −1 |
| | −1 −1 −1 1 1 1 1 −1 1 1 1 −1 −1 −1 −1 1 −1 −1 −1 1 −1 −1 −1 1 1 1 1 −1 1 1 1 |
| | −1 −1 −1 −1 1 1 1 1 −1 1 1 1 −1 −1 −1 −1 1 −1 −1 −1 1 −1 −1 −1 1 1 1 1 −1 1 1 |
| | 1 −1 1 1 −1 1 1 1 −1 1 1 1 −1 1 1 1 −1 1 −1 −1 1 −1 1 1 −1 1 −1 −1 1 −1 1 1 −1 1 |
| | 1 1 −1 1 1 1 −1 1 1 1 −1 1 1 1 −1 1 −1 −1 1 −1 1 1 −1 1 −1 −1 1 −1 1 1 −1 1 −1 |
| | −1 1 −1 1 1 −1 1 −1 −1 1 −1 1 1 −1 1 1 1 −1 1 1 1 −1 1 1 1 −1 1 1 1 −1 1 −1 −1 1 |
| | −1 1 1 −1 1 −1 −1 1 −1 1 1 −1 1 1 1 −1 1 1 1 −1 1 1 1 −1 1 1 1 −1 1 1 1 −1 1 1 1 |
| | −1 1 −1 −1 1 −1 −1 −1 1 −1 −1 −1 1 −1 1 1 −1 1 1 1 −1 1 −1 −1 1 −1 1 1 −1 1 1 |
| | 1 −1 1 −1 −1 1 −1 −1 −1 1 −1 −1 −1 1 −1 1 1 −1 1 1 1 −1 1 −1 −1 1 −1 −1 −1 1 |
| | −1 1 1 −1 1 1 1 −1 1 −1 −1 1 −1 1 1 −1 1 1 1 −1 1 −1 −1 1 −1 −1 −1 1 −1 −1 −1 |
| | 1 −1 1 1 −1 1 1 1 −1 1 −1 −1 1 −1 1 1 −1 1 1 1 −1 1 −1 −1 1 −1 −1 −1 1 −1 1 −1 |
| | 1 1 1 −1 1 1 1 −1 1 1 1 −1 1 1 1 −1 1 1 −1 1 −1 −1 1 −1 1 1 −1 1 −1 −1 1 −1 1 1 |
| | 1 −1 1 1 1 −1 1 1 1 −1 1 1 1 −1 1 1 −1 1 −1 −1 1 −1 1 1 −1 1 −1 −1 −1 1 −1 −1 1 |
| | −1 1 1 −1 1 −1 −1 1 −1 1 1 −1 1 −1 −1 −1 1 −1 −1 −1 1 −1 −1 −1 1 −1 −1 −1 1 |
| | −1 −1 1 −1 1 1 −1 1 −1 −1 1 −1 1 1 −1 1 −1 −1 −1 1 −1 −1 −1 1 −1 −1 −1 1 −1 |
| | −1 −1 1 −1 −1 −1 1 −1 −1 1 −1 1 1 1 −1 1 1 −1 1 −1 −1 1 −1 1 1 1 −1 1 1 −1 1 |
| | −1 −1 −1 1 −1 −1 −1 1 −1 −1 1 −1 1 1 1 −1 1 1 −1 1 −1 −1 1 −1 1 1 1 −1 1 1 −1 |
| | 1 −1 −1 1 −1 1 1 −1 1 −1 −1 −1 1 −1 −1 1 −1 1 1 1 −1 1 1 1 −1 1 1 −1 1 −1 −1 |
| | −1 1 −1 −1 1 −1 1 1 −1 1 −1 −1 −1 1 −1 −1 1 −1 1 1 1 −1 1 1 1 −1 1 1 −1 1 −1 |
| | −1 −1 1 −1 −1 1 −1 −1 −1 1 −1 −1 −1 1 −1 −1 −1 1 −1 −1 −1 −1 1 1 1 1 −1 −1 |
| | −1 −1 1 1 1 1 −1 −1 −1 1 −1 −1 −1 1 −1 −1 −1 1 −1 −1 −1 1 −1 −1 −1 −1 1 1 1 1 |
| | −1 −1 −1 −1 1 1 1 1 −1 −1 −1 −1 1 1 1 1 −1 −1 −1 −1 1 1 1 1 −1 −1 −1 1 −1 −1 |
| | −1 1 −1 −1 −1 1 −1 −1 −1 1 −1 −1 −1 −1 1 1 1 1 −1 −1 −1 −1 1 1 1 1 −1 −1 −1 1 |
| | −1 −1 −1 1 −1 −1 −1 1 −1 −1 −1 1 −1 −1 −1 −1 1 1 1 −1 1 1 1 1 −1 −1 −1 1 −1 |
| | −1 −1 1 −1 −1 −1 −1 1 1 1 −1 1 1 1 1 −1 −1 −1 −1 1 1 1 −1 1 1 1 1 −1 −1 −1 1 |
| | −1 −1 −1 1 −1 −1 −1 −1 1 1 1 −1 1 1 1 1 −1 −1 −1 1 −1 −1 −1 −1 1 1 1 −1 1 1 1 |
| | 1 −1 −1 −1 −1 1 1 1 −1 1 1 1 1 −1 −1 −1 1 −1 −1 −1 1 −1 −1 −1 −1 1 1 1 −1 1 1 |
| | 1 1 −1 −1 −1 −1 1 1 1 −1 1 1 1 1 −1 −1 −1 1 −1 −1 −1 |
| 16 | 1 1 1 1 1 1 1 1 1 1 −1 −1 1 1 −1 −1 1 1 1 1 1 1 1 1 1 1 −1 −1 1 1 −1 −1 1 1 1 1 1 |
| | 1 1 1 −1 −1 1 1 −1 −1 1 1 1 1 1 1 1 1 1 1 −1 −1 1 1 −1 −1 1 1 1 −1 1 −1 1 −1 1 |
| | −1 1 −1 −1 1 1 −1 −1 1 −1 1 −1 1 −1 1 −1 1 −1 1 1 −1 −1 1 1 −1 1 −1 1 −1 1 −1 |
| | 1 −1 −1 1 1 −1 −1 1 1 −1 −1 1 −1 1 −1 1 −1 1 1 −1 −1 1 1 −1 −1 1 1 −1 −1 1 1 |
| | −1 −1 1 1 −1 1 −1 1 −1 1 −1 1 −1 −1 1 1 −1 −1 1 1 −1 1 −1 1 −1 1 −1 1 −1 −1 1 |
| | 1 −1 −1 1 −1 1 −1 1 −1 1 −1 1 1 −1 −1 1 1 −1 −1 1 −1 1 −1 1 −1 1 −1 1 1 1 −1 |
| | −1 1 1 −1 −1 1 1 1 1 1 1 1 1 −1 −1 1 1 −1 −1 1 1 −1 −1 −1 −1 −1 −1 −1 −1 1 1 |
| | −1 −1 1 1 −1 −1 −1 −1 −1 −1 −1 −1 −1 −1 −1 −1 1 1 −1 −1 1 1 1 1 1 1 1 1 1 1 1 |
| | 1 1 1 −1 −1 −1 −1 1 1 −1 −1 −1 −1 1 1 1 1 1 1 −1 −1 −1 −1 1 1 −1 −1 −1 −1 1 1 |
| | 1 1 1 1 −1 −1 −1 −1 −1 −1 1 1 1 1 −1 −1 1 1 1 1 −1 −1 −1 −1 −1 −1 1 1 1 1 −1 |
| | −1 1 −1 1 −1 −1 1 −1 1 1 −1 −1 1 −1 1 1 −1 −1 1 −1 1 1 −1 1 1 −1 1 1 −1 1 −1 |
| | −1 1 1 −1 1 −1 −1 1 −1 1 −1 1 1 −1 1 −1 −1 1 −1 1 −1 1 1 −1 1 −1 1 −1 −1 1 −1 |
| | 1 1 −1 1 −1 −1 1 −1 1 1 −1 1 −1 1 −1 −1 1 −1 1 1 −1 −1 1 −1 1 1 −1 1 −1 1 −1 |
| | −1 1 −1 1 1 −1 −1 1 −1 1 1 −1 −1 1 −1 1 1 −1 1 −1 1 −1 −1 1 −1 1 1 −1 −1 1 −1 |
| | 1 1 −1 1 −1 1 1 −1 −1 −1 −1 1 1 1 1 1 −1 −1 −1 −1 −1 −1 1 1 1 1 −1 −1 −1 −1 |
| | −1 −1 1 1 1 1 1 1 −1 −1 −1 −1 1 1 −1 −1 −1 −1 1 1 1 1 −1 −1 1 1 1 1 −1 −1 1 1 1 |
| | 1 −1 −1 −1 −1 1 1 1 1 1 1 1 1 1 1 −1 −1 1 1 −1 −1 1 1 1 1 1 1 1 1 1 1 −1 −1 1 1 |
| | −1 −1 1 1 1 1 1 1 1 1 −1 −1 1 1 −1 −1 1 1 1 1 1 1 1 1 1 1 −1 −1 1 1 −1 −1 1 1 1 |
| | −1 1 −1 1 −1 1 −1 1 −1 1 1 −1 −1 1 −1 1 −1 1 −1 1 −1 1 −1 1 1 −1 −1 1 1 −1 |
| | 1 −1 1 −1 1 −1 1 −1 −1 1 1 −1 −1 1 1 −1 −1 1 −1 1 −1 1 −1 1 1 −1 −1 1 1 −1 −1 |
| | 1 1 −1 −1 1 1 −1 −1 1 1 −1 1 −1 1 −1 1 −1 1 −1 −1 1 1 −1 −1 1 1 −1 1 −1 1 −1 1 |
| | −1 1 −1 −1 1 1 −1 −1 1 −1 1 −1 1 −1 1 −1 1 1 −1 −1 1 1 −1 −1 1 −1 1 −1 1 −1 1 |
| | −1 1 1 1 −1 −1 1 1 −1 −1 1 1 1 1 1 1 1 1 −1 −1 1 1 −1 −1 1 1 −1 −1 −1 −1 −1 −1 |
| | −1 −1 1 1 −1 −1 1 1 −1 −1 −1 −1 −1 −1 −1 −1 −1 −1 −1 −1 1 1 −1 −1 1 1 1 1 1 1 |
| | 1 1 1 1 −1 −1 −1 −1 1 1 1 1 −1 −1 1 1 1 1 −1 −1 −1 −1 −1 −1 1 1 1 1 −1 −1 1 1 1 |
| | 1 −1 −1 −1 −1 −1 −1 1 1 1 1 1 1 −1 −1 −1 −1 1 1 −1 −1 −1 −1 1 1 1 1 1 1 −1 −1 |
| | −1 −1 1 1 −1 1 −1 1 1 −1 1 −1 −1 1 1 −1 1 −1 −1 1 1 −1 1 −1 −1 1 −1 1 1 −1 −1 |
| | 1 −1 1 1 −1 −1 1 −1 1 1 −1 1 −1 1 −1 −1 1 −1 1 1 −1 1 −1 1 −1 −1 1 −1 1 −1 1 1 |
| | −1 1 −1 −1 1 −1 1 1 −1 1 −1 −1 1 −1 1 −1 1 1 −1 1 −1 −1 1 1 −1 1 −1 −1 1 −1 1 |
| | −1 1 1 −1 1 −1 −1 1 1 −1 1 −1 −1 1 1 −1 1 −1 −1 1 −1 1 −1 1 1 −1 1 −1 −1 1 1 |
| | −1 1 −1 −1 1 −1 1 −1 −1 1 1 1 1 −1 −1 −1 −1 −1 −1 1 1 1 1 1 1 −1 −1 −1 −1 1 1 |
| | 1 1 1 1 −1 −1 −1 −1 −1 −1 1 1 1 1 −1 −1 1 1 1 1 −1 −1 −1 −1 1 1 −1 −1 −1 −1 1 |
| | 1 −1 −1 −1 −1 1 1 1 1 1 1 1 1 −1 −1 −1 −1 1 1 −1 −1 −1 −1 1 1 −1 −1 −1 −1 1 1 |
| | 1 1 −1 −1 1 1 1 1 −1 1 1 1 1 1 −1 −1 −1 −1 −1 −1 1 1 1 1 −1 −1 −1 −1 −1 −1 1 |
| | 1 1 1 1 1 −1 −1 −1 −1 1 1 1 −1 1 −1 −1 1 −1 1 1 −1 −1 1 −1 1 1 −1 1 −1 1 −1 −1 |
| | 1 −1 1 1 −1 −1 1 −1 1 1 −1 1 −1 1 −1 −1 1 −1 1 −1 1 1 −1 1 −1 −1 1 1 −1 1 −1 |
| | −1 1 −1 1 −1 1 1 −1 1 −1 −1 1 1 −1 −1 1 −1 1 1 −1 1 −1 1 −1 −1 1 −1 1 −1 1 1 |
| | −1 1 −1 −1 1 −1 1 −1 1 1 −1 1 −1 1 −1 −1 1 −1 1 1 −1 −1 1 −1 1 1 −1 1 −1 −1 1 |
| | 1 −1 1 −1 −1 1 1 −1 1 −1 1 −1 1 1 1 −1 −1 −1 −1 1 1 1 1 1 1 −1 −1 −1 −1 1 1 |
| | −1 −1 −1 −1 1 1 1 1 1 1 −1 −1 −1 −1 1 1 −1 −1 −1 −1 1 1 −1 −1 −1 −1 1 1 1 1 1 |
| | 1 −1 −1 −1 −1 1 1 −1 −1 −1 −1 1 1 1 1 1 1 1 1 1 1 1 1 1 1 −1 −1 1 1 −1 −1 −1 −1 |
| | −1 −1 −1 −1 −1 −1 −1 −1 1 1 −1 −1 1 1 1 1 1 1 1 1 1 1 −1 −1 1 1 −1 −1 1 1 −1 |
| | −1 −1 −1 −1 −1 −1 −1 1 1 −1 −1 1 1 −1 −1 1 −1 1 −1 1 −1 1 −1 1 −1 −1 1 1 −1 |
| | −1 1 1 −1 1 −1 1 −1 1 −1 1 −1 −1 1 1 −1 −1 1 1 −1 1 −1 1 −1 1 −1 −1 1 1 −1 −1 |
| | 1 1 −1 1 −1 1 −1 1 −1 1 −1 −1 1 1 −1 −1 1 1 −1 1 −1 −1 1 1 −1 −1 1 1 −1 1 −1 1 |
| | −1 1 −1 −1 1 1 −1 −1 1 1 −1 −1 1 −1 1 −1 1 −1 1 1 −1 −1 1 1 −1 −1 1 −1 1 −1 1 |
| | −1 1 −1 1 −1 1 1 −1 −1 1 1 −1 1 −1 1 −1 1 −1 1 −1 1 1 −1 −1 1 1 −1 −1 1 1 1 1 1 |
| | 1 1 1 1 1 −1 −1 1 1 −1 −1 1 1 1 1 1 1 1 1 1 1 −1 −1 1 1 −1 −1 −1 −1 −1 −1 −1 −1 |
| | −1 −1 1 1 −1 −1 1 1 −1 −1 −1 −1 −1 −1 −1 −1 −1 −1 1 1 1 1 −1 −1 −1 −1 1 1 −1 |
| | −1 −1 −1 1 1 −1 −1 −1 −1 1 1 1 1 −1 −1 1 1 1 1 −1 −1 1 1 1 1 −1 −1 −1 −1 −1 −1 |
| | 1 1 1 1 −1 −1 −1 −1 −1 −1 1 1 1 1 1 1 −1 −1 −1 −1 1 1 1 −1 1 −1 −1 1 −1 1 1 −1 |
| | −1 1 −1 1 1 −1 1 −1 1 −1 −1 1 −1 1 1 −1 −1 1 −1 1 1 −1 1 −1 1 −1 −1 1 −1 1 −1 |
| | 1 1 −1 1 −1 −1 1 1 −1 1 −1 −1 1 −1 1 −1 1 1 −1 1 −1 −1 1 1 −1 −1 1 −1 1 1 −1 1 |
| | −1 1 −1 −1 1 −1 1 −1 1 1 −1 1 −1 −1 1 −1 1 −1 1 1 −1 1 −1 1 −1 −1 1 −1 1 1 −1 |
| | −1 1 −1 1 1 −1 1 −1 −1 1 1 −1 1 −1 −1 1 1 −1 1 −1 −1 1 −1 1 1 1 −1 −1 −1 −1 1 |
| | 1 1 1 1 1 −1 −1 −1 −1 1 1 −1 −1 −1 −1 1 1 1 1 1 −1 −1 −1 −1 1 1 −1 −1 −1 −1 |
| | 1 1 −1 −1 −1 −1 1 1 1 1 1 1 −1 −1 −1 −1 1 1 −1 −1 −1 −1 1 1 1 1 −1 −1 −1 −1 −1 |
| | −1 −1 −1 −1 −1 1 1 −1 −1 1 1 1 1 1 1 1 1 1 1 1 1 −1 −1 1 1 −1 −1 −1 −1 −1 −1 |
| | −1 −1 −1 −1 1 1 −1 −1 1 1 −1 −1 1 1 1 1 1 1 1 1 −1 −1 1 1 −1 −1 1 1 −1 1 −1 1 |
| | −1 1 −1 1 −1 1 1 −1 −1 1 1 −1 −1 1 −1 1 −1 1 −1 1 −1 1 1 −1 −1 1 1 −1 −1 1 −1 |
| | 1 −1 1 −1 1 1 −1 −1 1 1 −1 −1 1 −1 1 −1 1 −1 1 −1 1 1 −1 −1 1 1 −1 −1 1 −1 1 1 |
| | −1 −1 1 1 −1 −1 1 −1 1 −1 1 −1 1 1 −1 −1 1 1 −1 −1 1 1 −1 1 −1 1 −1 1 −1 −1 1 |
| | 1 −1 −1 1 1 −1 1 −1 1 −1 1 −1 1 −1 1 −1 −1 1 1 −1 −1 1 −1 1 −1 1 −1 1 −1 1 −1 |
| | −1 1 1 −1 −1 1 1 −1 −1 −1 −1 −1 −1 −1 −1 −1 −1 1 1 −1 −1 1 1 −1 −1 −1 −1 −1 |
| | −1 −1 −1 −1 −1 1 1 −1 −1 1 1 1 1 1 1 1 1 1 1 −1 −1 1 1 −1 −1 1 1 1 1 1 1 1 1 1 1 |
| | 1 1 1 1 1 1 1 1 1 1 −1 −1 1 1 −1 −1 1 1 1 1 1 1 1 1 1 1 −1 −1 1 1 −1 −1 −1 −1 −1 |
| | −1 −1 −1 −1 −1 1 1 −1 −1 1 1 −1 −1 −1 −1 −1 −1 −1 −1 −1 −1 1 1 −1 −1 1 1 −1 |
| | −1 1 −1 1 −1 1 −1 1 −1 1 −1 −1 1 1 −1 −1 1 −1 1 −1 1 −1 1 −1 1 −1 1 1 −1 −1 1 |
| | 1 −1 −1 1 −1 1 −1 1 −1 1 1 −1 −1 1 1 −1 −1 1 1 −1 1 −1 1 −1 1 −1 −1 1 1 −1 −1 |
| | 1 1 −1 1 −1 −1 1 1 −1 −1 1 1 −1 1 −1 1 −1 1 −1 1 −1 −1 1 1 −1 −1 1 1 −1 1 −1 1 |
| | −1 1 −1 −1 1 1 −1 −1 1 1 −1 1 −1 1 −1 1 −1 1 −1 −1 1 1 −1 −1 1 1 −1 1 −1 1 −1 |
| | 1 −1 1 −1 1 1 −1 −1 1 1 −1 −1 1 1 1 1 1 1 1 1 −1 −1 1 1 −1 −1 1 1 −1 −1 −1 −1 |
| | −1 −1 −1 −1 −1 −1 1 1 −1 −1 1 1 1 1 1 1 1 1 1 1 1 1 −1 −1 1 1 −1 −1 −1 −1 −1 |
| | −1 −1 −1 −1 −1 1 1 1 1 −1 −1 −1 −1 1 1 −1 −1 −1 −1 1 1 1 1 1 1 −1 −1 −1 −1 1 1 |
| | −1 −1 −1 −1 1 1 −1 −1 −1 −1 1 1 1 1 1 1 −1 −1 −1 −1 1 1 −1 −1 −1 −1 1 1 1 1 1 |
| | 1 −1 −1 −1 −1 1 1 1 −1 1 −1 −1 1 −1 1 1 −1 −1 1 −1 1 1 −1 −1 1 −1 1 1 −1 1 −1 |
| | −1 1 1 −1 1 −1 −1 1 −1 1 −1 1 1 −1 1 −1 1 −1 −1 1 −1 1 1 −1 1 −1 1 −1 −1 1 −1 |
| | 1 −1 1 1 −1 1 −1 −1 1 1 −1 −1 1 −1 1 1 −1 1 −1 1 −1 −1 1 −1 1 1 −1 −1 1 −1 1 1 |
| | −1 1 −1 1 −1 −1 1 −1 1 −1 1 1 −1 1 −1 −1 1 1 −1 1 −1 −1 1 −1 1 −1 1 1 −1 1 −1 |
| | −1 1 1 −1 1 −1 −1 1 −1 1 1 1 −1 −1 −1 −1 1 1 1 1 1 1 −1 −1 −1 −1 −1 −1 1 1 1 1 |
| | −1 −1 −1 −1 −1 −1 1 1 1 1 −1 −1 1 1 1 1 −1 −1 1 1 1 1 −1 −1 −1 −1 1 1 −1 −1 −1 |
| | −1 1 1 −1 −1 −1 −1 1 1 1 1 1 1 1 1 1 1 1 1 1 1 −1 −1 1 1 −1 −1 1 1 1 1 1 1 1 1 1 1 |
| | −1 −1 1 1 −1 −1 −1 −1 −1 −1 −1 −1 −1 −1 1 1 −1 −1 1 1 −1 −1 −1 −1 −1 −1 −1 |
| | −1 −1 −1 1 1 −1 −1 1 1 −1 −1 1 −1 1 −1 1 −1 1 −1 1 −1 −1 1 1 −1 −1 1 −1 1 −1 1 |
| | −1 1 −1 1 −1 1 1 −1 −1 1 1 −1 −1 1 −1 1 −1 1 −1 1 1 −1 −1 1 1 −1 −1 1 1 −1 1 |
| | −1 1 −1 1 −1 −1 1 1 −1 −1 1 1 −1 1 −1 −1 1 1 −1 −1 1 1 −1 1 −1 1 −1 1 −1 1 −1 |
| | −1 1 1 −1 −1 1 1 −1 1 −1 1 −1 1 −1 −1 1 1 −1 −1 1 1 −1 1 −1 1 −1 1 −1 1 −1 −1 |
| | 1 1 −1 −1 1 1 −1 1 −1 1 −1 1 −1 1 −1 1 1 −1 −1 1 1 −1 −1 1 1 1 1 1 1 1 1 −1 −1 1 |
| | 1 −1 −1 1 1 −1 −1 −1 −1 −1 −1 −1 −1 −1 −1 1 1 −1 −1 1 1 1 1 1 1 1 1 1 1 1 1 −1 |
| | −1 1 1 −1 −1 −1 −1 −1 −1 −1 −1 −1 −1 −1 −1 −1 −1 1 1 1 1 −1 −1 1 1 1 1 −1 −1 |
| | −1 −1 −1 −1 1 1 1 1 −1 −1 1 1 1 1 −1 −1 1 1 1 1 −1 −1 −1 −1 −1 −1 1 1 1 1 −1 |
| | −1 1 1 1 1 −1 −1 −1 −1 −1 −1 1 1 1 1 −1 −1 −1 1 −1 1 1 −1 1 −1 −1 1 1 −1 1 −1 |
| | −1 1 1 −1 1 −1 −1 1 −1 1 1 −1 −1 1 −1 1 1 −1 1 −1 1 −1 −1 1 −1 1 −1 1 1 −1 1 |
| | −1 −1 1 −1 1 −1 1 1 −1 1 −1 1 −1 −1 1 −1 1 1 −1 −1 1 1 −1 1 −1 −1 1 −1 1 −1 1 |
| | 1 −1 1 −1 −1 1 1 −1 1 −1 −1 1 −1 1 −1 1 1 −1 1 −1 1 −1 −1 1 −1 1 1 −1 −1 1 −1 |
| | 1 1 −1 1 −1 1 −1 −1 1 −1 1 1 −1 −1 1 −1 1 −1 1 −1 −1 −1 1 1 1 1 −1 −1 −1 −1 |
| | −1 −1 1 1 1 1 1 1 −1 −1 −1 −1 1 1 1 1 1 1 −1 −1 −1 −1 1 1 −1 −1 −1 −1 1 1 −1 |
| | −1 −1 −1 1 1 1 1 −1 −1 1 1 1 1 −1 −1 1 1 1 1 −1 −1 −1 −1 1 1 1 1 −1 −1 −1 −1 1 |
| | 1 −1 −1 −1 −1 1 1 −1 −1 −1 −1 1 1 1 1 −1 −1 1 1 1 1 −1 −1 −1 −1 −1 −1 1 1 1 1 |
| | 1 1 −1 −1 −1 −1 1 1 1 1 1 1 −1 −1 −1 −1 −1 −1 1 1 1 1 −1 −1 1 −1 1 −1 −1 1 −1 |
| | 1 1 −1 −1 1 −1 1 1 −1 1 −1 1 −1 −1 1 −1 1 1 −1 −1 1 −1 1 1 −1 −1 1 −1 1 1 −1 1 |
| | −1 1 −1 −1 1 −1 1 1 −1 −1 1 −1 1 1 −1 1 −1 1 −1 −1 1 −1 1 1 −1 1 −1 −1 1 −1 1 |
| | 1 −1 1 −1 1 −1 −1 1 −1 1 −1 1 1 −1 1 −1 −1 1 −1 1 −1 1 1 −1 1 −1 −1 1 1 −1 1 |
| | −1 −1 1 1 −1 1 −1 −1 1 −1 1 1 −1 −1 1 −1 1 1 −1 −1 1 −1 1 1 −1 1 −1 1 1 −1 −1 |
| | −1 −1 1 1 1 1 1 1 −1 −1 −1 −1 1 1 −1 −1 −1 −1 1 1 1 1 1 1 −1 −1 −1 −1 −1 −1 1 |
| | 1 1 1 −1 −1 1 1 1 1 −1 −1 −1 −1 −1 −1 1 1 1 1 −1 −1 1 1 1 1 −1 −1 −1 −1 1 1 1 1 |
| | 1 1 1 1 1 1 −1 −1 1 1 −1 −1 −1 −1 −1 −1 −1 −1 −1 −1 −1 −1 1 1 −1 −1 1 1 −1 −1 |
| | −1 −1 −1 −1 −1 −1 1 1 −1 −1 1 1 −1 −1 1 1 1 1 1 1 1 1 −1 −1 1 1 −1 −1 1 1 1 −1 |
| | 1 −1 1 −1 1 −1 1 −1 −1 1 1 −1 −1 1 1 −1 1 −1 1 −1 1 −1 1 −1 −1 1 1 −1 −1 1 −1 |
| | 1 −1 1 −1 1 −1 1 1 −1 −1 1 1 −1 −1 1 −1 1 −1 1 −1 1 −1 1 1 −1 −1 1 1 −1 −1 1 1 |
| | −1 −1 1 1 −1 −1 1 1 −1 1 −1 1 −1 1 −1 −1 1 1 −1 −1 1 1 −1 −1 1 −1 1 −1 1 −1 1 |
| | −1 1 1 −1 −1 1 1 −1 1 −1 1 −1 1 −1 1 −1 1 −1 −1 1 1 −1 −1 1 −1 1 −1 1 −1 1 −1 |
| | 1 1 1 −1 −1 1 1 −1 −1 1 1 1 1 1 1 1 1 1 1 −1 −1 1 1 −1 −1 1 1 1 1 1 1 1 1 −1 −1 1 |
| | 1 −1 −1 1 1 1 1 1 1 1 1 1 1 −1 −1 1 1 −1 −1 1 1 1 1 1 1 1 1 1 1 1 1 1 1 −1 −1 −1 |
| | −1 1 1 −1 −1 −1 −1 1 1 −1 −1 −1 −1 1 1 1 1 −1 −1 1 1 1 1 −1 −1 −1 −1 −1 −1 1 1 |
| | 1 1 1 1 −1 −1 −1 −1 1 1 1 1 1 1 −1 −1 −1 −1 −1 −1 1 1 1 1 −1 −1 1 −1 1 −1 −1 1 |
| | −1 1 1 −1 −1 1 −1 1 1 −1 1 −1 1 −1 −1 1 −1 1 1 −1 −1 1 −1 1 1 −1 −1 1 −1 1 1 |
| | −1 1 −1 1 −1 −1 1 −1 1 1 −1 −1 1 −1 1 1 −1 1 −1 1 −1 −1 1 −1 1 1 −1 1 −1 −1 1 |
| | −1 1 1 −1 1 −1 1 −1 −1 1 −1 1 −1 1 1 −1 1 −1 −1 1 −1 1 −1 1 1 −1 1 −1 −1 1 1 |
| | −1 1 −1 −1 1 1 −1 1 −1 −1 1 −1 1 1 −1 −1 1 −1 1 1 −1 −1 1 −1 1 1 −1 1 −1 1 1 |
| | −1 −1 −1 −1 1 1 1 1 1 1 −1 −1 −1 −1 1 1 −1 −1 −1 −1 1 1 1 1 1 1 −1 −1 −1 −1 −1 |
| | −1 1 1 1 1 −1 −1 1 1 1 1 −1 −1 −1 −1 −1 −1 1 1 1 1 −1 −1 1 1 1 1 −1 −1 −1 −1 |
| | −1 −1 −1 −1 −1 −1 −1 −1 −1 −1 1 1 −1 −1 1 1 1 1 1 1 1 1 1 1 1 1 −1 −1 1 1 −1 |
| | −1 1 1 1 1 1 1 1 1 −1 −1 1 1 −1 −1 1 1 −1 −1 −1 −1 −1 −1 −1 −1 1 1 −1 −1 1 1 |
| | −1 −1 −1 1 −1 1 −1 1 −1 1 −1 1 1 −1 −1 1 1 −1 −1 1 −1 1 −1 1 −1 1 −1 1 1 −1 −1 |
| | 1 1 −1 1 −1 1 −1 1 −1 1 −1 −1 1 1 −1 −1 1 1 −1 1 −1 1 −1 1 −1 1 −1 −1 1 1 −1 |
| | −1 1 1 −1 −1 1 1 −1 −1 1 1 −1 −1 1 −1 1 −1 1 −1 1 1 −1 −1 1 1 −1 −1 1 1 −1 1 |
| | −1 1 −1 1 −1 1 −1 −1 1 1 −1 −1 1 −1 1 −1 1 −1 1 −1 1 −1 1 1 −1 −1 1 1 −1 1 −1 |
| | 1 −1 1 −1 1 −1 −1 −1 1 1 −1 −1 1 1 −1 −1 −1 −1 −1 −1 −1 −1 −1 −1 1 1 −1 −1 1 |
| | 1 −1 −1 −1 −1 −1 −1 −1 −1 1 1 −1 −1 1 1 −1 −1 −1 −1 −1 −1 −1 −1 −1 −1 1 1 −1 |
| | −1 1 1 −1 −1 −1 −1 −1 −1 −1 −1 −1 −1 −1 −1 −1 −1 −1 −1 −1 −1 −1 −1 1 1 −1 |
| | −1 1 1 −1 −1 −1 −1 −1 −1 −1 −1 −1 −1 1 1 −1 −1 1 1 −1 −1 −1 −1 −1 −1 −1 −1 1 |
| | 1 −1 −1 1 1 −1 −1 −1 −1 −1 −1 −1 −1 −1 −1 1 1 −1 −1 1 1 −1 −1 −1 1 −1 1 −1 1 |
| | −1 1 −1 1 1 −1 −1 1 1 −1 1 −1 1 −1 1 −1 1 −1 1 −1 −1 1 1 −1 −1 1 −1 1 −1 1 −1 |
| | 1 −1 1 1 −1 −1 1 1 −1 −1 1 1 −1 1 −1 1 −1 1 −1 −1 1 1 −1 −1 1 1 −1 −1 1 1 −1 |
| | −1 1 1 −1 −1 1 −1 1 −1 1 −1 1 −1 1 1 −1 −1 1 1 −1 −1 1 −1 1 −1 1 −1 1 −1 1 1 |
| | −1 −1 1 1 −1 1 −1 1 −1 1 −1 1 −1 −1 1 1 −1 −1 1 1 −1 1 −1 1 −1 1 −1 1 −1 −1 −1 |
| | 1 1 −1 −1 1 1 −1 −1 −1 −1 −1 −1 −1 −1 1 1 −1 −1 1 1 −1 −1 1 1 1 1 1 1 1 1 −1 |
| | −1 1 1 −1 −1 1 1 1 1 1 1 1 1 1 1 1 1 −1 −1 1 1 −1 −1 −1 −1 −1 −1 −1 −1 −1 −1 |
| | −1 −1 −1 −1 1 1 1 1 −1 −1 1 1 1 1 −1 −1 −1 −1 −1 −1 1 1 1 1 −1 −1 1 1 1 1 −1 |
| | −1 −1 −1 −1 −1 1 1 1 1 1 1 −1 −1 −1 −1 1 1 −1 −1 −1 −1 1 1 1 1 1 1 −1 −1 −1 −1 |
| | 1 1 −1 1 −1 1 1 −1 1 −1 −1 1 1 −1 1 −1 −1 1 1 −1 1 −1 −1 1 −1 1 1 −1 −1 1 −1 1 |
| | 1 −1 −1 1 −1 1 1 −1 1 −1 1 −1 −1 1 −1 1 1 −1 1 −1 1 −1 −1 1 −1 1 −1 1 1 −1 1 |
| | −1 −1 1 −1 1 1 −1 1 −1 −1 1 −1 1 −1 1 1 −1 1 −1 −1 1 1 −1 1 −1 −1 1 −1 1 −1 1 |
| | 1 −1 1 −1 −1 1 1 −1 1 −1 −1 1 1 −1 1 −1 −1 1 −1 1 −1 1 1 −1 1 −1 −1 1 1 −1 1 |
| | −1 −1 1 −1 1 −1 −1 1 1 1 1 −1 −1 −1 −1 −1 −1 1 1 1 1 1 1 −1 −1 −1 −1 1 1 1 1 1 |
| | 1 −1 −1 −1 −1 −1 −1 1 1 1 1 −1 −1 1 1 1 1 −1 −1 −1 −1 1 1 −1 −1 −1 −1 1 1 −1 |
| | −1 −1 −1 1 1 1 1 −1 −1 −1 −1 −1 −1 −1 −1 −1 −1 1 1 −1 −1 1 1 −1 −1 −1 −1 −1 |
| | −1 −1 −1 −1 −1 1 1 −1 −1 1 1 −1 −1 −1 −1 −1 −1 −1 −1 1 1 −1 −1 1 1 −1 −1 −1 |
| | −1 −1 −1 −1 −1 −1 −1 1 1 −1 −1 1 1 −1 −1 −1 1 −1 1 −1 1 −1 1 −1 1 1 −1 −1 1 1 |
| | −1 1 −1 1 −1 1 −1 1 −1 1 −1 −1 1 1 −1 −1 1 −1 1 −1 1 −1 1 −1 1 1 −1 −1 1 1 −1 |
| | −1 1 1 −1 1 −1 1 −1 1 −1 −1 1 1 −1 −1 1 1 −1 −1 1 1 −1 −1 1 1 −1 −1 1 −1 1 −1 |
| | 1 −1 1 −1 1 1 −1 −1 1 1 −1 −1 1 −1 1 −1 1 −1 1 −1 1 1 −1 −1 1 1 −1 1 −1 1 −1 1 |
| | −1 1 −1 −1 1 1 −1 −1 1 1 −1 1 −1 1 −1 1 −1 1 −1 −1 −1 1 1 −1 −1 1 1 −1 −1 −1 |
| | −1 −1 −1 −1 −1 1 1 −1 −1 1 1 −1 −1 1 1 1 1 1 1 1 1 −1 −1 1 1 −1 −1 1 1 1 1 1 1 1 |
| | 1 1 1 1 1 −1 −1 1 1 −1 −1 −1 −1 −1 −1 −1 −1 −1 −1 1 1 1 1 −1 −1 −1 1 1 −1 |
| | −1 −1 −1 1 1 1 1 1 1 −1 −1 −1 −1 1 1 −1 −1 −1 −1 1 1 1 1 1 1 −1 −1 −1 −1 −1 −1 |
| | 1 1 1 1 −1 −1 1 1 1 1 −1 −1 −1 −1 −1 −1 1 1 1 1 −1 −1 1 −1 1 −1 −1 1 −1 1 1 −1 |
| | −1 1 −1 1 1 −1 −1 1 −1 1 1 −1 1 −1 −1 1 1 −1 1 −1 −1 1 1 −1 1 −1 −1 1 −1 1 −1 |
| | 1 1 −1 1 −1 −1 1 −1 1 −1 1 1 −1 1 −1 1 −1 −1 1 −1 1 1 −1 1 −1 −1 1 −1 1 1 −1 1 |
| | −1 1 −1 −1 1 −1 1 1 −1 −1 1 −1 1 1 −1 1 −1 1 −1 −1 1 −1 1 1 −1 −1 1 −1 1 1 −1 |
| | −1 1 −1 1 1 −1 1 −1 1 −1 −1 1 −1 1 1 −1 −1 1 −1 1 1 −1 1 −1 1 1 −1 −1 −1 −1 1 |
| | 1 1 1 1 1 −1 −1 −1 −1 −1 −1 1 1 1 1 −1 −1 −1 −1 −1 −1 1 1 1 1 1 1 −1 −1 −1 −1 |
| | 1 1 −1 −1 −1 −1 1 1 1 1 −1 −1 1 1 1 1 −1 −1 1 1 1 1 −1 −1 −1 −1 −1 −1 −1 −1 1 |
| | 1 1 1 −1 −1 1 1 1 1 −1 −1 1 1 1 1 −1 −1 −1 −1 1 1 −1 −1 −1 −1 1 1 −1 −1 −1 −1 |
| | 1 1 1 1 1 1 −1 −1 −1 −1 1 1 1 1 1 1 −1 −1 −1 −1 −1 −1 1 1 1 1 −1 −1 −1 1 −1 1 1 |
| | −1 1 −1 −1 1 1 −1 1 −1 −1 1 −1 1 −1 1 1 −1 1 −1 −1 1 1 −1 1 −1 −1 1 −1 1 −1 1 |
| | 1 −1 1 −1 1 −1 −1 1 −1 1 1 −1 −1 1 −1 1 1 −1 1 −1 1 −1 −1 1 −1 1 1 −1 −1 1 1 |
| | −1 1 −1 −1 1 −1 1 −1 1 1 −1 1 −1 1 −1 −1 1 −1 1 1 −1 1 −1 1 −1 −1 1 −1 1 −1 1 |
| | 1 −1 1 −1 −1 1 1 −1 1 −1 −1 1 −1 1 1 −1 −1 1 −1 1 1 −1 −1 1 −1 1 1 −1 1 −1 −1 |
| | −1 1 1 1 1 −1 −1 −1 −1 −1 −1 1 1 1 1 −1 −1 1 1 1 1 −1 −1 −1 −1 −1 −1 1 1 1 1 |
| | −1 −1 1 1 1 1 −1 −1 1 1 1 1 −1 −1 −1 −1 −1 −1 1 1 1 1 −1 −1 1 1 1 1 −1 −1 −1 |
| | −1 −1 −1 −1 −1 −1 −1 −1 −1 −1 −1 1 1 −1 −1 1 1 1 1 1 1 1 1 1 1 1 1 −1 −1 1 1 |
| | −1 −1 −1 −1 −1 −1 −1 −1 −1 −1 1 1 −1 −1 1 1 −1 −1 1 1 1 1 1 1 1 1 −1 −1 1 1 −1 |
| | −1 1 1 −1 1 −1 1 −1 1 −1 1 −1 1 1 −1 −1 1 1 −1 −1 1 −1 1 −1 1 −1 1 −1 1 1 −1 |
| | −1 1 1 −1 −1 1 −1 1 −1 1 −1 1 1 −1 −1 1 1 −1 −1 1 −1 1 −1 1 −1 1 −1 1 1 −1 −1 |
| | 1 1 −1 −1 1 −1 1 1 −1 −1 1 1 −1 −1 1 −1 1 −1 1 −1 1 1 −1 −1 1 1 −1 −1 1 1 −1 1 |
| | −1 1 −1 1 −1 −1 1 1 −1 −1 1 1 −1 1 −1 1 −1 1 −1 1 −1 1 −1 −1 1 1 −1 −1 1 −1 1 |
| | −1 1 −1 1 −1 1 −1 −1 1 1 −1 −1 1 1 −1 −1 −1 −1 −1 −1 −1 −1 −1 −1 1 1 −1 −1 1 |
| | 1 −1 −1 −1 −1 −1 −1 −1 −1 −1 −1 1 1 −1 −1 1 1 1 1 1 1 1 1 1 1 −1 −1 1 1 −1 −1 |
| | 1 1 1 1 1 1 1 1 1 1 −1 −1 −1 −1 1 1 1 1 −1 −1 1 1 1 1 −1 −1 1 1 1 1 −1 −1 −1 −1 |
| | 1 1 −1 −1 −1 −1 1 1 −1 −1 −1 −1 1 1 1 1 1 1 −1 −1 −1 −1 1 1 1 1 1 1 −1 −1 −1 |
| | −1 −1 −1 1 1 1 1 −1 −1 −1 1 −1 1 1 −1 1 −1 −1 1 1 −1 1 −1 −1 1 −1 1 −1 1 1 −1 |
| | 1 −1 −1 1 1 −1 1 −1 −1 1 −1 1 −1 1 1 −1 1 −1 1 −1 −1 1 −1 1 1 −1 −1 1 −1 1 1 |
| | −1 1 −1 1 −1 −1 1 −1 1 1 −1 −1 1 1 −1 1 −1 −1 1 −1 1 −1 1 1 −1 1 −1 1 −1 −1 1 |
| | −1 1 1 −1 1 −1 1 −1 −1 1 −1 1 −1 1 1 −1 1 −1 −1 1 1 −1 1 −1 −1 1 −1 1 1 −1 −1 |
| | 1 −1 1 1 −1 −1 1 −1 1 1 −1 1 −1 −1 −1 1 1 1 1 −1 −1 −1 −1 −1 −1 1 1 1 1 −1 −1 |
| | 1 1 1 1 −1 −1 −1 −1 −1 −1 1 1 1 1 −1 −1 1 1 1 1 −1 −1 1 1 1 1 −1 −1 −1 −1 −1 |
| | −1 1 1 1 1 −1 −1 1 1 1 1 −1 −1 −1 −1 1 1 1 1 1 1 1 1 1 −1 −1 1 1 −1 −1 −1 −1 |
| | −1 −1 −1 −1 −1 −1 −1 −1 1 1 −1 −1 1 1 1 1 1 1 1 1 1 1 −1 −1 1 1 −1 −1 1 1 −1 |
| | −1 −1 −1 −1 −1 −1 −1 1 1 −1 −1 1 1 −1 −1 1 −1 1 −1 1 −1 1 −1 1 −1 −1 1 1 −1 |
| | −1 1 1 −1 1 −1 1 −1 1 −1 1 −1 −1 1 1 −1 −1 1 1 −1 1 −1 1 −1 1 −1 −1 1 1 −1 −1 |
| | 1 1 −1 1 −1 1 −1 1 −1 1 −1 −1 1 1 −1 −1 1 1 −1 1 −1 −1 1 1 −1 −1 1 1 −1 1 −1 1 |
| | −1 1 −1 −1 1 1 −1 −1 1 1 −1 −1 1 −1 1 −1 1 −1 1 1 −1 −1 1 1 −1 −1 1 −1 1 −1 1 |
| | −1 1 −1 1 −1 1 1 −1 −1 1 1 −1 1 −1 1 −1 1 −1 1 −1 1 1 −1 −1 1 1 −1 −1 1 1 1 1 1 |
| | 1 1 1 1 1 −1 −1 1 1 −1 −1 1 1 1 1 1 1 1 1 1 1 −1 −1 1 1 −1 −1 −1 −1 −1 −1 −1 −1 |
| | −1 −1 1 1 −1 −1 1 1 −1 −1 −1 −1 −1 −1 −1 −1 −1 −1 1 1 1 1 1 1 1 1 1 1 −1 −1 1 |
| | 1 −1 −1 1 1 1 1 1 1 1 1 1 1 −1 −1 1 1 −1 −1 −1 −1 −1 −1 −1 −1 −1 −1 1 1 −1 −1 |
| | 1 1 −1 −1 −1 −1 −1 −1 −1 −1 −1 −1 1 1 −1 −1 1 1 −1 −1 1 −1 1 −1 1 −1 1 −1 1 |
| | −1 −1 1 1 −1 −1 1 −1 1 −1 1 −1 1 −1 1 −1 1 1 −1 −1 1 1 −1 −1 1 −1 1 −1 1 −1 1 |
| | 1 −1 −1 1 1 −1 −1 1 1 −1 1 −1 1 −1 1 −1 −1 1 1 −1 −1 1 1 −1 1 −1 −1 1 1 −1 −1 |
| | 1 1 −1 1 −1 1 −1 1 −1 1 −1 −1 1 1 −1 −1 1 1 −1 1 −1 1 −1 1 −1 −1 1 1 −1 −1 1 1 |
| | −1 1 −1 1 −1 1 −1 1 −1 −1 1 1 −1 −1 1 1 −1 1 −1 1 −1 1 −1 1 −1 1 1 −1 −1 1 1 |
| | −1 −1 1 1 1 1 1 1 1 1 −1 −1 1 1 −1 −1 1 1 −1 −1 −1 −1 −1 −1 −1 −1 −1 −1 1 1 −1 |
| | −1 1 1 1 1 1 1 1 1 1 1 1 1 −1 −1 1 1 −1 −1 −1 −1 −1 −1 −1 −1 −1 −1 1 1 1 1 −1 |
| | −1 −1 −1 1 1 −1 −1 −1 −1 1 1 1 1 1 1 −1 −1 −1 −1 1 1 −1 −1 −1 −1 1 1 −1 −1 −1 |
| | −1 1 1 1 1 1 1 −1 −1 −1 −1 1 1 −1 −1 −1 −1 1 1 1 1 1 1 −1 −1 −1 −1 1 1 1 −1 1 |
| | −1 −1 1 −1 1 1 −1 −1 1 −1 1 1 −1 −1 1 −1 1 1 −1 1 −1 −1 1 1 −1 1 −1 −1 1 −1 1 |
| | −1 1 1 −1 1 −1 1 −1 −1 1 −1 1 1 −1 1 −1 1 −1 −1 1 −1 1 −1 1 1 −1 1 −1 −1 1 1 |
| | −1 −1 1 −1 1 1 −1 1 −1 1 −1 −1 1 −1 1 1 −1 −1 1 −1 1 1 −1 1 −1 1 −1 −1 1 −1 1 |
| | −1 1 1 −1 1 −1 −1 1 1 −1 1 −1 −1 1 −1 1 −1 1 1 −1 1 −1 −1 1 1 −1 1 −1 −1 1 −1 |
| | 1 1 1 −1 −1 −1 −1 1 1 1 1 1 1 −1 −1 −1 −1 −1 −1 1 1 1 1 −1 −1 −1 −1 −1 −1 1 1 |
| | 1 1 −1 −1 1 1 1 −1 −1 1 1 1 1 −1 −1 −1 −1 1 1 −1 −1 −1 −1 1 1 −1 −1 −1 −1 1 |
| | 1 1 1 1 1 1 1 1 1 1 1 1 1 −1 −1 1 1 −1 −1 1 1 1 1 1 1 1 1 1 1 −1 −1 1 1 −1 −1 −1 |
| | −1 −1 −1 −1 −1 −1 −1 1 1 −1 −1 1 1 −1 −1 −1 −1 −1 −1 −1 −1 −1 −1 1 1 −1 −1 1 |
| | 1 −1 −1 1 −1 1 −1 1 −1 1 −1 1 −1 −1 1 1 −1 −1 1 −1 1 −1 1 −1 1 −1 1 −1 1 1 −1 |
| | −1 1 1 −1 −1 1 −1 1 −1 1 −1 1 1 −1 −1 1 1 −1 −1 1 1 −1 1 −1 1 −1 1 −1 −1 1 1 |
| | −1 −1 1 1 −1 1 −1 −1 1 1 −1 −1 1 1 −1 1 −1 1 −1 1 −1 1 −1 −1 1 1 −1 −1 1 1 −1 |
| | 1 −1 1 −1 1 −1 −1 1 1 −1 −1 1 1 −1 1 −1 1 −1 1 −1 1 −1 −1 1 1 −1 −1 1 1 −1 1 |
| | −1 1 −1 1 −1 1 −1 1 1 −1 −1 1 1 −1 −1 1 1 1 1 1 1 1 1 −1 −1 1 1 −1 −1 1 1 −1 −1 |
| | −1 −1 −1 −1 −1 −1 −1 −1 1 1 −1 −1 1 1 1 1 1 1 1 1 1 1 1 1 −1 −1 1 1 −1 −1 −1 |
| | −1 −1 −1 −1 −1 −1 −1 −1 −1 −1 −1 1 1 1 1 −1 −1 1 1 1 1 −1 −1 −1 −1 −1 −1 1 1 |
| | 1 1 −1 −1 1 1 1 1 −1 −1 1 1 1 1 −1 −1 −1 −1 −1 −1 1 1 1 1 −1 −1 1 1 1 1 −1 −1 |
| | −1 −1 −1 −1 1 1 1 1 −1 −1 −1 1 −1 1 1 −1 1 −1 −1 1 1 −1 1 −1 −1 1 1 −1 1 −1 −1 |
| | 1 −1 1 1 −1 −1 1 −1 1 1 −1 1 −1 1 −1 −1 1 −1 1 −1 1 1 −1 1 −1 −1 1 −1 1 −1 1 1 |
| | −1 1 −1 1 −1 −1 1 −1 1 1 −1 −1 1 1 −1 1 −1 −1 1 −1 1 −1 1 1 −1 1 −1 −1 1 1 −1 |
| | 1 −1 −1 1 −1 1 −1 1 1 −1 1 −1 1 −1 −1 1 −1 1 1 −1 −1 1 −1 1 1 −1 1 −1 1 −1 −1 |
| | 1 −1 1 1 −1 −1 1 −1 1 1 −1 1 −1 −1 −1 1 1 1 1 −1 −1 −1 −1 −1 −1 1 1 1 1 1 1 −1 |
| | −1 −1 −1 1 1 1 1 1 1 −1 −1 −1 −1 1 1 −1 −1 −1 −1 1 1 −1 −1 −1 −1 1 1 1 1 −1 −1 |
| | 1 1 1 1 −1 −1 1 1 1 1 −1 −1 −1 −1 1 1 1 1 −1 −1 −1 −1 1 1 −1 −1 −1 −1 1 1 −1 |
| | −1 −1 −1 1 1 1 1 −1 −1 1 1 1 1 −1 −1 −1 −1 −1 −1 1 1 1 1 1 1 −1 −1 −1 −1 1 1 1 |
| | 1 1 1 −1 −1 −1 −1 −1 −1 1 1 1 1 −1 −1 1 −1 1 −1 −1 1 −1 1 1 −1 −1 1 −1 1 1 −1 |
| | 1 −1 1 −1 −1 1 −1 1 1 −1 −1 1 −1 1 1 −1 −1 1 −1 1 1 −1 1 −1 1 −1 −1 1 −1 1 1 |
| | −1 −1 1 −1 1 1 −1 1 −1 1 −1 −1 1 −1 1 1 −1 1 −1 −1 1 −1 1 1 −1 1 −1 1 −1 −1 1 |
| | −1 1 −1 1 1 −1 1 −1 −1 1 −1 1 −1 1 1 −1 1 −1 −1 1 1 −1 1 −1 −1 1 1 −1 1 −1 −1 |
| | 1 −1 1 1 −1 −1 1 −1 1 1 −1 −1 1 −1 1 1 −1 1 −1 1 1 −1 −1 −1 −1 1 1 1 1 1 1 −1 |
| | −1 −1 −1 1 1 −1 −1 −1 −1 1 1 1 1 1 1 −1 −1 −1 −1 −1 −1 1 1 1 1 −1 −1 1 1 1 1 |
| | −1 −1 −1 −1 −1 −1 1 1 1 1 −1 −1 1 1 1 1 −1 −1 −1 −1 1 1 1 1 1 1 1 1 1 1 −1 −1 1 |
| | 1 −1 −1 −1 −1 −1 −1 −1 −1 −1 −1 −1 −1 1 1 −1 −1 1 1 −1 −1 −1 −1 −1 −1 −1 −1 |
| | 1 1 −1 −1 1 1 −1 −1 1 1 1 1 1 1 1 1 −1 −1 1 1 −1 −1 1 1 1 −1 1 −1 1 −1 1 −1 1 −1 |
| | −1 1 1 −1 −1 1 1 −1 1 −1 1 −1 1 −1 1 −1 −1 1 1 −1 −1 1 −1 1 −1 1 −1 1 −1 1 1 |
| | −1 −1 1 1 −1 −1 1 −1 1 −1 1 −1 1 −1 1 1 −1 −1 1 1 −1 −1 1 1 −1 −1 1 1 −1 −1 1 |
| | 1 −1 1 −1 1 −1 1 −1 −1 1 1 −1 −1 1 1 −1 −1 1 −1 1 −1 1 −1 1 −1 1 1 −1 −1 1 1 |
| | −1 1 −1 1 −1 1 −1 1 −1 1 −1 −1 1 1 −1 −1 1 −1 1 −1 1 −1 1 −1 1 1 1 −1 −1 1 1 |
| | −1 −1 1 1 1 1 1 1 1 1 1 1 −1 −1 1 1 −1 −1 1 1 1 1 1 1 1 1 −1 −1 1 1 −1 −1 1 1 1 1 |
| | 1 1 1 1 1 1 −1 −1 1 1 −1 −1 1 1 1 1 1 1 1 1 1 1 1 1 1 1 −1 −1 −1 −1 1 1 −1 −1 −1 |
| | −1 1 1 −1 −1 −1 −1 1 1 1 1 −1 −1 1 1 1 1 −1 −1 −1 −1 −1 −1 1 1 1 1 1 1 −1 −1 |
| | −1 −1 1 1 1 1 1 1 −1 −1 −1 −1 −1 −1 1 1 1 1 −1 −1 1 −1 1 −1 −1 1 −1 1 1 −1 −1 |
| | 1 −1 1 1 −1 1 −1 1 −1 −1 1 −1 1 1 −1 −1 1 −1 1 1 −1 −1 1 −1 1 1 −1 1 −1 1 −1 |
| | −1 1 −1 1 1 −1 −1 1 −1 1 1 −1 1 −1 1 −1 −1 1 −1 1 1 −1 1 −1 −1 1 −1 1 1 −1 1 |
| | −1 1 −1 −1 1 −1 1 −1 1 1 −1 1 −1 −1 1 −1 1 −1 1 1 −1 1 −1 −1 1 1 −1 1 −1 −1 1 |
| | 1 −1 1 −1 −1 1 −1 1 1 −1 −1 1 −1 1 1 −1 −1 1 −1 1 1 −1 1 −1 1 1 −1 −1 −1 −1 1 |
| | 1 1 1 1 1 −1 −1 −1 −1 1 1 −1 −1 −1 −1 1 1 1 1 1 1 −1 −1 −1 −1 −1 −1 1 1 1 1 −1 |
| | −1 1 1 1 1 −1 −1 −1 −1 −1 −1 1 1 1 1 −1 −1 1 1 1 1 −1 −1 −1 −1 −1 −1 −1 −1 −1 |
| | −1 −1 −1 −1 −1 1 1 −1 −1 1 1 1 1 1 1 1 1 1 1 1 1 −1 −1 1 1 −1 −1 1 1 1 1 1 1 1 1 |
| | −1 −1 1 1 −1 −1 1 1 −1 −1 −1 −1 −1 −1 −1 −1 1 1 −1 −1 1 1 −1 −1 −1 1 −1 1 −1 |
| | 1 −1 1 −1 1 1 −1 −1 1 1 −1 −1 1 −1 1 −1 1 −1 1 −1 1 1 −1 −1 1 1 −1 1 −1 1 −1 1 |
| | −1 1 −1 −1 1 1 −1 −1 1 1 −1 1 −1 1 −1 1 −1 1 −1 −1 1 1 −1 −1 1 1 −1 −1 1 1 −1 |
| | −1 1 1 −1 −1 1 −1 1 −1 1 −1 1 1 −1 −1 1 1 −1 −1 1 1 −1 1 −1 1 −1 1 −1 1 −1 −1 |
| | 1 1 −1 −1 1 −1 1 −1 1 −1 1 −1 1 −1 1 1 −1 −1 1 1 −1 1 −1 1 −1 1 −1 1 −1 −1 −1 |
| | 1 1 −1 −1 1 1 −1 −1 −1 −1 −1 −1 −1 −1 −1 −1 1 1 −1 −1 1 1 −1 −1 −1 −1 −1 −1 |
| | −1 −1 1 1 −1 −1 1 1 −1 −1 −1 −1 −1 −1 −1 −1 −1 −1 1 1 −1 −1 1 1 −1 −1 −1 −1 |
| | −1 −1 −1 −1 −1 −1 |

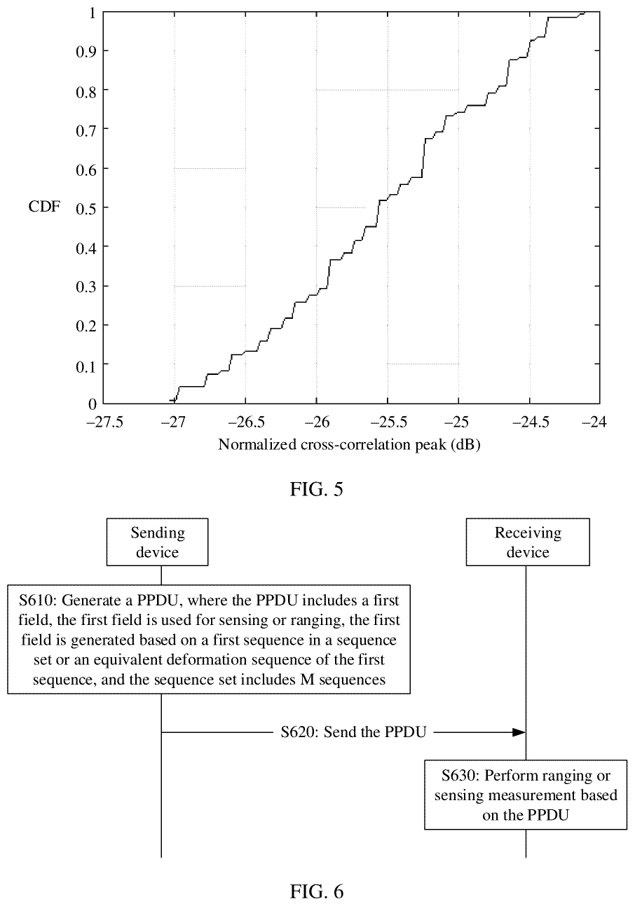

FIG. 5 is a diagram of a cumulative distribution function of cross-correlation results between 16 selected sequences. In FIG. 5, a horizontal axis shows a normalized cross correlation peak, and a vertical axis shows a value of a cumulative distribution function (cumulative distribution function, CDF). It can be learned that the normalized cross-correlation peak (namely, the first threshold) is between −27 dB and −24 dB, and the 16 sequences have a low cross-correlation feature.

S420: The sending device sends the PPDU to a receiving device. Correspondingly, the receiving device receives the PPDU from the sending device.

S430: The receiving device performs ranging or sensing measurement based on the PPDU.

Specifically, the receiving device performs correlation processing on the first field in the PPDU based on the first sequence, implements sensing measurement or ranging based on a correlation result, and generates a sensing measurement/ranging report.

It should be understood that, how the receiving device learns of the first sequence is not limited in this application. For example, the sending device and the receiving device may negotiate in advance about which sequence in the sequence set is to be used.

It can be learned that in the method, a sequence set having a zero-correlation zone is constructed based on a Golay sequence pair having a zero-correlation zone and a Golay sequence pair having a low cross-correlation, to well support sensing measurement and ranging. In addition, sequences in the sequence set have a low cross-correlation, and may support a plurality of devices to perform concurrent transmission, to reduce interference when the plurality of devices simultaneously perform sensing or ranging.

FIG. 6 is a schematic block diagram of another physical layer protocol data unit sending and receiving method according to an embodiment of this application.

S610: A sending device generates a PPDU.

The PPDU includes a first field, the first field is used for sensing or ranging, the first field is generated based on a first sequence in a sequence set or an equivalent deformation sequence of the first sequence, the sequence set includes M sequences, the M sequences are sequences corresponding to a first set in L sequences whose lengths are N, a cross-correlation between any two sequences in the M sequences is less than or equal to a second threshold, the first set includes L sampling values, each of the L sequences corresponds to one sampling value, each sequence is a sampling sequence obtained by sampling, by using a corresponding sampling value, a second sequence whose length is N, and the second sequence is an n-level m-sequence.

It should be understood that a length of the n-level m-sequence is N=2ⁿ−1.

For example, the equivalent deformation sequence of the first sequence includes a sequence generated by negating the first sequence or reversing the first sequence.

For example, the first set is a set of odd numbers less than or equal to N, or the first set is a set of even numbers less than or equal to N.

It may be understood that, that the cross-correlation herein is less than or equal to the first threshold means that a normalized cross-correlation peak of any two sequences is less than or equal to the second threshold. A smaller second threshold indicates a lower cross-correlation between two sequences.

For example, the STS field in FIG. 2 may be replaced with the first field. Details are not described herein again.

For ease of understanding, the following describes a possible generation step of a sequence set including M sequences.
Step 1: Construct a shift register based on a primitive polynomial F(x) whose exponent is n, and generate an n-level m-sequence, where the n-level m-sequence is denoted as a sequence s (namely, the second sequence), and a length of the sequence s is N=2ⁿ−1.
Step 2: Separately sample the sequence s by using the L sampling values in the first set, to obtain L sampling sequences whose lengths are N. A sampling sequence by performing sampling by using a sampling value d satisfies the following formula:

$${s}_{d} ( n ) = \{ \begin{matrix}s ( d * n + {k}_{0} ) , & if d * n + {k}_{0} \leq N \\ s ( r ) , r = mod ( d * n + {k}_{0} - 1 , N ) + 1 , & if d * n + {k}_{0} > N\end{matrix} .$$

s_{d}(n) is an n^{th} element in the sampling sequence, and n=1, 2, . . . , N. s(j) is a j^{th} element in the sequence s, j=1, 2, . . . , N, and k₀ is a natural number.

In this way, the L sampling sequences whose lengths are N may be respectively obtained based on the L sampling values in the first set.

It should be understood that, for the same sampling value d, values of k₀ are different, and corresponding sampling sequences are in a cyclic shift relationship.
Step 3: Select, based on the second threshold, the M sequences from the L sampling sequences whose lengths are N. The cross-correlation between any two sequences in the M sequences is less than or equal to the second threshold.

The following provides descriptions by using an example.

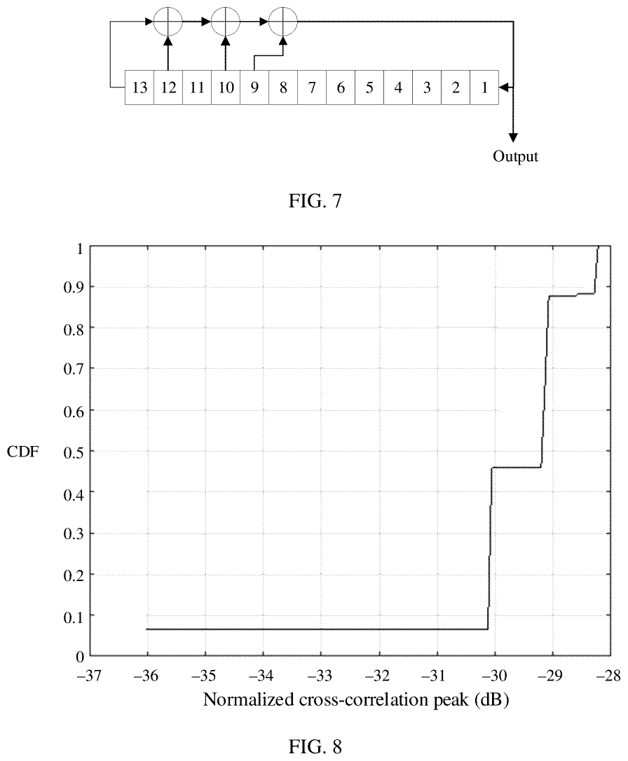

The primitive polynomial F(x)=x¹³+x¹²+x¹⁰+x⁹+1 in step 1 is used as an example. A shift register shown in FIG. 7 may be constructed to generate a sequence s (namely, an example of the second sequence) whose length is 2¹³−1. A possible generated sequence s is shown as follows: [0, 0, 0, 0, 0, 0, 0, 0, 1, 0, 0, 1, 0, 0, 0, 0, 0, 1, 1, 0, 0, 0, 0, 1, 1, 0, 1, 0, 1, 1, 0, 1, 1, 0, 1, 0, 1, 0, 1, 0, 0, 0, 0, 0, 1, 0, 0, 0, 0, 1, 1, 1, 0, 1, 1, 0, 1, 1, 1, 0, 0, 0, 1, 0, 0, 0, 0, 1, 0, 0, 0, 0, 1, 0, 1, 1, 1, 1, 0, 1, 1, 1, 1, 1, 1, 1, 1, 1, 1, 0, 1, 1, 0, 0, 0, 0, 0, 0, 1, 1, 0, 0, 1, 0, 1, 0, 0, 1, 0, 1, 1, 1, 0, 1, 0, 1, 0, 0, 1, 1, 1, 0, 1, 1, 0, 0, 1, 0, 1, 0, 0, 1, 0, 0, 1, 1, 0, 1, 0, 1, 0, 0, 0, 0, 1, 1, 0, 1, 0, 0, 1, 1, 1, 1, 0, 1, 0, 1, 1, 0, 1, 0, 1, 1, 1, 1, 0, 1, 0, 0, 1, 0, 1, 1, 1, 1, 1, 1, 1, 0, 0, 1, 1, 1, 1, 0, 0, 0, 1, 0, 1, 1, 0, 1, 1, 0, 0, 0, 1, 1, 1, 0, 0, 0, 0, 1, 0, 0, 0, 0, 0, 0, 0, 1, 1, 1, 0, 1, 1, 0, 0, 0, 1, 0, 0, 0, 1, 0, 0, 1, 0, 0, 1, 0, 1, 0, 1, 0, 0, 0, 0, 0, 0, 1, 0, 0, 0, 1, 1, 1, 0, 0, 1, 1, 0, 1, 0, 0, 0, 0, 0, 1, 1, 1, 0, 1, 1, 1, 1, 0, 1, 0, 0, 0, 1, 0, 1, 1, 1, 1, 1, 1, 1, 0, 1, 1, 1, 1, 1, 0, 0, 0, 1, 1, 0, 1, 1, 0, 1, 0, 0, 0, 0, 1, 0, 0, 0, 0, 1, 1, 1, 1, 1, 1, 0, 1, 1, 1, 0, 0, 1, 0, 0, 1, 1, 0, 1, 0, 0, 1, 0, 0, 0, 1, 1, 0, 1, 1, 0, 0, 0, 1, 0, 0, 1, 0, 0, 0, 1, 0, 0, 1, 0, 0, 0, 0, 1, 0, 1, 0, 0, 0, 0, 1, 1, 1, 1, 1, 0, 1, 1, 1, 1, 0, 0, 1, 0, 1, 1, 0, 1, 1, 1, 0, 1, 0, 1, 1, 0, 0, 0, 1, 0, 1, 1, 0, 1, 0, 1, 0, 0, 1, 1, 1, 0, 0, 1, 0, 0, 1, 0, 1, 0, 0, 0, 1, 0, 0, 0, 0, 1, 0, 1, 1, 0, 1, 0, 1, 1, 1, 1, 1, 1, 0, 0, 1, 0, 1, 1, 1, 0, 0, 1, 0, 1, 0, 1, 1, 1, 0, 0, 1, 0, 1, 0, 0, 1, 1, 0, 0, 1, 0, 1, 0, 1, 0, 1, 1, 1, 1, 0, 1, 0, 0, 0, 0, 1, 1, 1, 1, 1, 1, 1, 1, 1, 1, 0, 0, 1, 0, 0, 0, 0, 0, 0, 1, 0, 1, 0, 0, 1, 1, 0, 0, 1, 1, 1, 0, 1, 0, 1, 1, 1, 1, 1, 0, 0, 1, 1, 0, 1, 1, 1, 0, 1, 0, 1, 1, 1, 0, 0, 1, 0, 1, 1, 0, 1, 1, 0, 0, 1, 0, 1, 0, 0, 0, 1, 1, 1, 0, 0, 0, 0, 1, 1, 0, 0, 0, 0, 0, 0, 1, 1, 0, 1, 1, 0, 1, 0, 0, 1, 0, 1, 0, 0, 0, 0, 1, 1, 0, 0, 1, 0, 1, 1, 1, 1, 0, 1, 1, 1, 0, 1, 1, 1, 1, 1, 1, 0, 1, 0, 1, 0, 1, 1, 0, 1, 1, 1, 0, 0, 0, 1, 0, 1, 1, 1, 0, 0, 0, 0, 1, 1, 0, 1, 0, 1, 0, 1, 0, 1, 0, 0, 1, 1, 0, 0, 0, 1, 1, 0, 1, 0, 1, 1, 1, 0, 0, 0, 1, 0, 1, 0, 1, 1, 0, 0, 0, 0, 1, 1, 0, 0, 1, 0, 1, 0, 1, 1, 0, 1, 1, 0, 0, 1, 0, 0, 1, 0, 0, 0, 1, 0, 1, 1, 0, 0, 1, 0, 1, 1, 1, 1, 0, 0, 0, 0, 1, 1, 0, 1, 1, 1, 1, 0, 0, 1, 1, 0, 0, 1, 0, 0, 1, 0, 1, 1, 1, 0, 1, 0, 0, 0, 1, 1, 1, 1, 0, 1, 0, 0, 1, 1, 0, 0, 1, 1, 1, 0, 1, 1, 1, 1, 0, 0, 0, 1, 0, 1, 0, 1, 0, 1, 0, 1, 0, 0, 0, 1, 0, 1, 1, 1, 1, 1, 0, 0, 1, 1, 1, 1, 1, 1, 0, 1, 0, 1, 0, 0, 1, 0, 1, 1, 0, 1, 0, 0, 1, 1, 0, 1, 0, 0, 1, 1, 1, 0, 1, 1, 0, 1, 1, 0, 1, 0, 0, 1, 0, 0, 0, 0, 0, 0, 1, 1, 0, 0, 0, 1, 1, 0, 0, 1, 0, 1, 1, 0, 1, 1, 1, 1, 0, 1, 1, 0, 1, 0, 0, 1, 0, 1, 0, 1, 1, 1, 1, 0, 0, 1, 1, 1, 0, 1, 1, 0, 0, 1, 1, 1, 0, 0, 0, 1, 1, 1, 0, 0, 0, 1, 0, 0, 0, 1, 0, 0, 0, 1, 0, 0, 0, 0, 0, 0, 0, 0, 1, 1, 0, 1, 1, 0, 0, 0, 0, 1, 0, 1, 0, 0, 0, 1, 0, 1, 1, 1, 1, 0, 1, 1, 0, 1, 1, 1, 1, 1, 1, 1, 0, 0, 0, 0, 1, 1, 0, 0, 0, 1, 0, 0, 1, 0, 0, 1, 1, 1, 0, 0, 1, 0, 0, 1, 1, 0, 0, 0, 1, 1, 0, 0, 0, 1, 1, 1, 0, 0, 0, 1, 1, 0, 0, 0, 0, 0, 0, 0, 1, 1, 0, 1, 0, 0, 0, 0, 1, 0, 1, 0, 1, 1, 1, 1, 0, 1, 1, 1, 0, 0, 1, 1, 1, 1, 1, 0, 0, 1, 1, 0, 1, 0, 1, 1, 1, 1, 0, 1, 1, 0, 1, 0, 1, 1, 1, 1, 1, 0, 0, 0, 1, 0, 1, 1, 1, 0, 1, 0, 0, 0, 1, 1, 1, 1, 0, 0, 1, 1, 1, 0, 0, 0, 1, 0, 1, 1, 0, 0, 0, 0, 0, 0, 1, 0, 1, 0, 0, 0, 1, 0, 0, 1, 1, 1, 0, 1, 1, 0, 1, 0, 0, 1, 0, 0, 1, 0, 0, 0, 1, 1, 0, 0, 0, 0, 0, 0, 0, 1, 0, 0, 1, 1, 0, 1, 0, 0, 1, 1, 0, 0, 1, 1, 0, 1, 0, 0, 1, 1, 1, 1, 1, 1, 0, 0, 0, 0, 1, 1, 0, 0, 1, 0, 0, 1, 0, 1, 0, 1, 1, 1, 0, 0, 0, 0, 1, 0, 0, 1, 1, 0, 0, 1, 1, 1, 0, 0, 0, 1, 1, 0, 0, 0, 0, 0, 0, 1, 1, 0, 0, 0, 1, 0, 0, 1, 0, 1, 0, 1, 0, 1, 1, 1, 0, 0, 0, 1, 1, 0, 0, 0, 1, 0, 0, 0, 0, 0, 1, 1, 0, 0, 1, 0, 1, 1, 0, 1, 0, 1, 1, 1, 0, 1, 1, 0, 0, 1, 0, 1, 0, 1, 0, 0, 0, 1, 1, 0, 1, 1, 0, 0, 1, 0, 0, 1, 1, 0, 0, 0, 1, 1, 1, 1, 0, 1, 1, 0, 1, 1, 0, 0, 1, 0, 1, 1, 0, 0, 1, 1, 0, 0, 1, 1, 1, 1, 0, 1, 0, 0, 1, 1, 1, 0, 1, 1, 1, 1, 1, 0, 1, 0, 0, 1, 0, 1, 1, 0, 1, 1, 1, 1, 0, 0, 1, 1, 0, 0, 0, 1, 1, 1, 0, 1, 1, 1, 1, 0, 0, 0, 0, 0, 1, 0, 1, 1, 1, 0, 0, 1, 0, 1, 1, 1, 1, 1, 0, 0, 1, 0, 1, 1, 1, 1, 0, 1, 0, 1, 0, 1, 1, 1, 1, 1, 1, 1, 0, 0, 0, 1, 1, 1, 0, 0, 0, 1, 0, 0, 0, 0, 0, 0, 0, 0, 0, 1, 0, 1, 1, 0, 0, 0, 0, 0, 1, 1, 1, 1, 0, 1, 0, 1, 0, 1, 0, 0, 1, 1, 1, 1, 0, 0, 00, 0, 1, 0, 1, 0, 1, 1, 0, 0, 1, 1, 1, 1, 0, 0, 1, 0, 1, 1, 1, 0, 1, 1, 0, 1, 0, 1, 1, 0, 1, 1, 0, 0, 1, 0, 1, 0, 1, 1, 1, 1, 0, 1, 1, 0, 0, 0, 1, 1, 1, 1, 0, 1, 0, 0, 0, 0, 0, 0, 1, 1, 1, 1, 1, 1, 0, 0, 1, 0, 0, 1, 0, 0, 0, 1, 0, 1, 0, 0, 0, 0, 0, 1, 0, 1, 1, 0, 1, 1, 1, 0, 1, 1, 1, 0, 1, 0, 0, 0, 1, 0, 1, 0, 1, 1, 1, 0, 0, 0, 1, 1, 0, 0, 1, 1, 0, 0, 0, 0, 0, 1, 1, 1, 1, 1, 1, 0, 1, 0, 1, 0, 0, 1, 0, 0, 1, 1, 1, 0, 0, 1, 0, 0, 0, 0, 1, 0, 0, 0, 1, 0, 0, 1, 1, 1, 1, 0, 1, 0, 1, 0, 0, 1, 0, 1, 1, 1, 1, 0, 0, 1, 0, 0, 1, 1, 1, 1, 1, 0, 1, 0, 0, 0, 1, 0, 1, 0, 1, 1, 1, 1, 1, 0, 1, 1, 0, 0, 1, 1, 1, 0, 1, 1, 0, 0, 1, 1, 1, 0, 0, 1, 0, 0, 1, 1, 1, 0, 0, 0, 1, 0, 0, 0, 1, 0, 0, 0, 0, 0, 1, 0, 1, 0, 1, 0, 1, 1, 0, 1, 1, 1, 0, 0, 0, 0, 1, 0, 0, 0, 1, 0, 0, 0, 1, 1, 1, 0, 1, 0, 1, 0, 1, 0, 0, 0, 0, 1, 1, 0, 0, 0, 0, 1, 1, 1, 1, 0, 1, 1, 0, 1, 1, 0, 0, 1, 1, 1, 0, 0, 0, 0, 0, 1, 1, 1, 0, 0, 0, 0, 1, 0, 1, 0, 0, 0, 0, 0, 1, 1, 1, 1, 0, 1, 1, 1, 0, 1, 0, 0, 1, 1, 1, 0, 1, 0, 1, 1, 1, 0, 1, 0, 0, 1, 1, 0, 1, 1, 0, 1, 1, 1, 0, 1, 1, 0, 0, 0, 0, 0, 1, 0, 1, 0, 0, 1, 0, 1, 0, 1, 1, 1, 0, 1, 0, 0, 1, 0, 0, 1, 1, 0, 1, 1, 1, 0, 0, 0, 0, 1, 1, 0, 0, 1, 0, 0, 0, 1, 1, 0, 1, 1, 1, 0, 0, 1, 0, 0, 1, 0, 0, 1, 0, 0, 1, 0, 0, 0, 0, 0, 0, 0, 0, 0, 0, 0, 1, 1, 0, 0, 0, 0, 0, 0, 0, 1, 0, 1, 1, 0, 1, 0, 0, 0, 1, 1, 1, 1, 0, 0, 1, 1, 1, 0, 0, 0, 1, 1, 0, 1, 1, 0, 0, 0, 0, 0, 0, 1, 0, 0, 0, 1, 0, 1, 0, 0, 1, 1, 0, 1, 0, 1, 1, 0, 1, 0, 1, 1, 0, 1, 0, 1, 0, 0, 1, 0, 1, 0, 0, 1, 0, 0, 1, 0, 0, 1, 0, 1, 0, 0, 0, 0, 0, 0, 0, 0, 1, 0, 1, 1, 1, 0, 0, 0, 0, 1, 1, 1, 1, 1, 0, 0, 0, 1, 1, 0, 0, 1, 0, 1, 0, 0, 0, 0, 1, 1, 1, 0, 1, 0, 1, 1, 1, 1, 0, 0, 0, 1, 1, 0, 1, 1, 1, 1, 0, 0, 0, 0, 1, 0, 0, 1, 1, 1, 0, 0, 1, 1, 1, 0, 0, 1, 0, 0, 0, 1, 1, 0, 0, 0, 1, 0, 0, 1, 0, 0, 1, 1, 0, 0, 1, 0, 0, 0, 0, 0, 1, 1, 1, 1, 0, 0, 1, 1, 0, 1, 0, 0, 1, 1, 0, 1, 1, 1, 0, 1, 1, 0, 1, 1, 0, 0, 1, 0, 1, 0, 0, 0, 0, 0, 1, 1, 0, 1, 0, 1, 1, 1, 0, 1, 0, 1, 0, 1, 0, 1, 1, 0, 1, 1, 0, 0, 0, 0, 0, 1, 0, 0, 0, 0, 1, 0, 1, 0, 1, 1, 0, 1, 1, 1, 1, 1, 0, 0, 1, 0, 0, 0, 1, 1, 0, 1, 0, 1, 0, 0, 1, 0, 0, 1, 0, 1, 0, 0, 1, 0, 0, 0, 0, 0, 1, 0, 1, 0, 0, 0, 1, 1, 0, 1, 1, 1, 0, 1, 1, 0, 0, 1, 0, 0, 1, 0, 1, 0, 0, 1, 1, 0, 0, 0, 0, 1, 0, 1, 0, 1, 1, 1, 0, 1, 1, 1, 1, 0, 0, 1, 1, 0, 1, 0, 1, 1, 1, 0, 1, 1, 1, 0, 1, 0, 1, 1, 0, 1, 0, 1, 0, 1, 1, 0, 1, 0, 0, 1, 0, 0, 0, 1, 0, 0, 1, 1, 0, 0, 0, 1, 0, 1, 0, 0, 1, 1, 1, 0, 0, 1, 1, 0, 1, 0, 1, 0, 0, 0, 1, 1, 1, 0, 1, 0, 0, 1, 1, 0, 0, 0, 0, 1, 1, 1, 0, 1, 1, 1, 0, 1, 1, 0, 0, 0, 1, 0, 1, 0, 1, 0, 0, 1, 0, 0, 1, 1, 0, 0, 0, 1, 0, 0, 0, 0, 1, 1, 1, 0, 0, 1, 0, 1, 1, 1, 0, 0, 0, 0, 1, 0, 1, 1, 1, 0, 0, 0, 1, 1, 1, 1, 1, 1, 0, 0, 0, 0, 0, 0, 1, 0, 0, 1, 0, 0, 1, 0, 0, 1, 1, 0, 0, 0, 0, 0, 0, 0, 0, 1, 1, 1, 0, 1, 0, 0, 0, 0, 1, 0, 0, 0, 1, 1, 1, 1, 1, 1, 1, 0, 1, 0, 0, 0, 1, 0, 0, 0, 1, 1, 1, 1, 1, 0, 1, 0, 1, 0, 0, 0, 1, 0, 1, 1, 1, 0, 0, 1, 1, 0, 1, 1, 1, 1, 0, 0, 1, 1, 1, 0, 0, 1, 1, 1, 0, 1, 1, 0, 0, 0, 1, 1, 0, 0, 1, 0, 0, 1, 0, 0, 0, 1, 1, 1, 0, 0, 0, 0, 0, 1, 0, 0, 0, 0, 0, 0, 1, 0, 1, 1, 0, 1, 1, 0, 0, 1, 1, 1, 1, 0, 0, 0, 0, 1, 1, 1, 0, 1, 1, 0, 0, 1, 1, 0, 0, 0, 1, 0, 0, 1, 1, 1, 1, 1, 0, 0, 1, 0, 0, 1, 0, 1, 0, 1, 0, 1, 0, 0, 0, 0, 1, 0, 0, 0, 0, 0, 1, 1, 1, 1, 1, 0, 1, 1, 0, 1, 0, 0, 1, 0, 1, 1, 0, 0, 0, 1, 1, 0, 1, 1, 0, 0, 0, 1, 0, 1, 1, 1, 1, 1, 0, 1, 1, 1, 0, 0, 0, 1, 0, 1, 1, 0, 1, 0, 0, 0, 0, 1, 1, 1, 0, 0, 1, 1, 1, 1, 1, 0, 1, 0, 0, 0, 1, 0, 0, 1, 0, 1, 1, 0, 1, 0, 1, 0, 0, 1, 0, 1, 1, 0, 1, 0, 0, 1, 1, 0, 0, 1, 1, 1, 1, 0, 0, 0, 0, 1, 1, 1, 1, 1, 1, 0, 1, 1, 0, 0, 1, 0, 1, 1, 0, 1, 1, 0, 0, 1, 0, 0, 1, 1, 1, 1, 1, 0, 0, 0, 1, 0, 1, 0, 0, 1, 0, 0, 0, 1, 0, 1, 1, 0, 1, 0, 1, 0, 0, 1, 0, 0, 0, 1, 0, 1, 0, 0, 0, 1, 1, 1, 0, 0, 0, 0, 1, 0, 0, 0, 1, 1, 0, 0, 1, 0, 0, 0, 1, 0, 0, 1, 1, 1, 0, 0, 1, 1, 1, 0, 1, 0, 1, 1, 0, 1, 0, 0, 1, 1, 0, 1, 0, 0, 0, 1, 1, 1, 0, 1, 1, 1, 1, 0, 0, 1, 1, 1, 0, 1, 1, 0, 1, 0, 1, 1, 0, 0, 1, 0, 0, 0, 1, 0, 1, 0, 1, 1, 0, 0, 1, 0, 1, 1, 0, 1, 0, 1, 0, 1, 1, 0, 0, 0, 1, 1, 0, 1, 0, 0, 0, 0, 0, 0, 0, 0, 0, 1, 0, 1, 0, 0, 0, 1, 0, 0, 0, 1, 1, 1, 1, 1, 0, 1, 0, 0, 0, 1, 0, 1, 1, 0, 0, 1, 0, 1, 1, 1, 0, 1, 1, 0, 10, 0, 1, 1, 0, 0, 1, 1, 1, 0, 1, 0, 1, 1, 1, 0, 1, 1, 1, 1, 0, 1, 1, 1, 1, 1, 0, 1, 1, 1, 1, 0, 1, 1, 0, 1, 1, 0, 1, 0, 1, 1, 0, 0, 0, 0, 0, 0, 0, 1, 1, 1, 0, 0, 1, 0, 0, 0, 1, 0, 0, 0, 0, 1, 0, 0, 1, 0, 1, 0, 1, 1, 1, 1, 0, 0, 0, 1, 0, 0, 1, 1, 1, 1, 0, 0, 0, 1, 0, 0, 1, 0, 1, 1, 0, 0, 0, 1, 0, 0, 0, 1, 1, 0, 1, 0, 0, 1, 0, 1, 1, 0, 1, 1, 0, 0, 1, 0, 1, 0, 0, 1, 1, 0, 1, 1, 0, 1, 0, 1, 0, 1, 1, 0, 0, 0, 0, 1, 0, 0, 0, 1, 0, 1, 0, 1, 1, 1, 0, 1, 0, 1, 1, 0, 0, 1, 1, 0, 1, 1, 0, 1, 0, 1, 1, 1, 1, 0, 0, 0, 1, 0, 1, 1, 1, 1, 0, 0, 1, 1, 1, 1, 1, 1, 1, 1, 0, 1, 1, 0, 1, 0, 0, 0, 0, 1, 1, 0, 0, 0, 1, 1, 1, 1, 1, 0, 1, 1, 0, 0, 0, 0, 1, 0, 1, 1, 0, 0, 1, 0, 1, 1, 1, 1, 1, 0, 1, 1, 0, 1, 1, 1, 1, 0, 1, 1, 0, 0, 0, 0, 1, 1, 1, 1, 0, 0, 1, 0, 1, 1, 0, 0, 1, 1, 0, 1, 0, 1, 1, 0, 1, 1, 1, 1, 0, 1, 0, 1, 0, 0, 0, 1, 1, 1, 1, 1, 0, 0, 1, 1, 0, 0, 0, 1, 0, 1, 0, 1, 1, 1, 1, 0, 0, 1, 1, 1, 1, 1, 1, 1, 0, 1, 1, 1, 0, 1, 1, 0, 1, 1, 1, 0, 1, 1, 0, 0, 1, 1, 0, 1, 0, 1, 0, 0, 1, 1, 1, 1, 0, 1, 0, 0, 1, 0, 1, 0, 1, 1, 1, 1, 1, 0, 0, 1, 0, 0, 1, 1, 1, 0, 1, 0, 1, 0, 0, 0, 1, 0, 0, 1, 1, 0, 0, 1, 1, 0, 1, 0, 0, 1, 1, 1, 1, 1, 1, 0, 1, 1, 0, 1, 0, 1, 0, 0, 1, 1, 0, 0, 0, 1, 0, 0, 1, 0, 1, 1, 1, 0, 0, 1, 0, 0, 0, 1, 1, 1, 0, 0, 1, 0, 0, 1, 0, 0, 0, 0, 0, 1, 0, 0, 0, 0, 0, 1, 1, 0, 1, 1, 0, 1, 1, 0, 1, 0, 1, 0, 0, 0, 0, 0, 0, 0, 1, 0, 0, 1, 1, 1, 0, 0, 0, 1, 1, 0, 0, 1, 0, 0, 0, 0, 0, 0, 1, 1, 1, 0, 0, 1, 1, 0, 0, 1, 0, 0, 0, 0, 1, 1, 1, 1, 1, 0, 0, 1, 1, 1, 0, 0, 1, 0, 1, 0, 1, 1, 0, 0, 0, 1, 0, 1, 0, 0, 1, 0, 1, 0, 0, 1, 1, 0, 1, 0, 0, 1, 0, 1, 0, 1, 1, 0, 1, 1, 0, 0, 1, 0, 0, 1, 0, 0, 0, 0, 1, 1, 0, 0, 0, 0, 0, 1, 1, 1, 0, 1, 1, 0, 1, 0, 1, 0, 0, 0, 1, 0, 0, 0, 1, 0, 0, 1, 1, 0, 1, 0, 1, 0, 1, 0, 0, 1, 1, 0, 1, 0, 0, 0, 0, 1, 0, 1, 1, 0, 1, 1, 1, 1, 1, 1, 1, 1, 0, 0, 0, 1, 1, 0, 0, 0, 1, 0, 0, 0, 1, 1, 0, 1, 1, 1, 0, 1, 1, 1, 0, 1, 0, 0, 1, 0, 1, 0, 1, 0, 1, 1, 1, 0, 0, 0, 0, 0, 1, 1, 0, 0, 1, 0, 0, 1, 1, 1, 0, 1, 1, 1, 0, 0, 0, 1, 0, 0, 1, 0, 1, 0, 0, 0, 0, 1, 0, 0, 0, 1, 0, 1, 1, 1, 1, 0, 1, 0, 1, 1, 1, 1, 1, 0, 1, 1, 1, 0, 1, 1, 1, 0, 1, 1, 0, 1, 0, 1, 0, 1, 0, 1, 0, 0, 0, 1, 0, 0, 0, 0, 0, 1, 1, 0, 1, 0, 1, 1, 0, 0, 1, 0, 1, 0, 1, 0, 1, 0, 1, 1, 0, 1, 0, 0, 0, 0, 0, 0, 1, 0, 0, 0, 0, 1, 1, 1, 1, 0, 0, 1, 1, 01, 0, 1, 1, 1, 1, 1, 0, 1, 1, 0, 0, 0, 1, 1, 0, 1, 1, 0, 0, 1, 0, 0, 0, 1, 0, 0, 0, 1, 1, 0, 0, 1, 0, 1, 0, 1, 0, 0, 1, 1, 0, 1, 0, 0, 0, 1, 0, 1, 0, 1, 1, 1, 1, 0, 1, 1, 0, 1, 0, 1, 0, 1, 1, 1, 0, 0, 0, 0, 1, 01, 0, 0, 0, 0, 0, 1, 0, 1, 0, 1, 0, 0, 1, 1, 0, 1, 1, 0, 0, 1, 1, 1, 1, 1, 0, 1, 0, 1, 1, 1, 0, 1, 0, 1, 1, 1, 0, 1, 1, 0, 1, 1, 0, 1, 1, 0, 1, 0, 0, 0, 0, 0, 0, 0, 1, 1, 1, 1, 0, 0, 0, 0, 0, 1, 0, 0, 0, 1, 1, 0, 0, 1, 0, 1, 1, 0, 0, 1, 1, 1, 1, 0, 1, 1, 0, 1, 1, 1, 0, 1, 1, 1, 0, 0, 0, 0, 1, 0, 1, 0, 1, 0, 1, 0, 1, 1, 1, 0, 0, 0, 0, 1, 1, 0, 0, 0, 1, 0, 0, 0, 1, 0, 0, 0, 1, 1, 0, 1, 1, 0, 1, 1, 0, 0, 0, 1, 0, 0, 0, 0, 0, 1, 0, 1, 0, 1, 1, 0, 1, 1, 1, 0, 0, 0, 1, 1, 1, 1, 1, 1, 1, 0, 0, 1, 1, 0, 1, 0, 0, 0, 1, 0, 0, 1, 1, 0, 1, 1, 1, 0, 1, 0, 0, 1, 1, 0, 0, 1, 0, 1, 1, 1, 0, 1, 1, 1, 0, 1, 1, 1, 0, 1, 0, 1, 1, 1, 1, 0, 1, 1, 0, 1, 1, 1, 1, 0, 0, 1, 0, 1, 0, 0, 0, 1, 1, 0, 0, 1, 1, 1, 1, 0, 0, 1, 1, 1, 1, 0, 1, 0, 1, 0, 1, 1, 0, 1, 1, 1, 1, 0, 0, 0, 1, 0, 0, 0, 1, 1, 1, 0, 0, 0, 1, 1, 0, 0, 0, 0, 0, 1, 1, 1, 1, 0, 0, 0, 1, 0, 1, 0, 0, 1, 0, 0, 0, 0, 1, 1, 0, 1, 0, 0, 0, 1, 1, 0, 1, 1, 1, 0, 1, 1, 1, 1, 1, 0, 1, 1, 0, 0, 0, 1, 1, 0, 1, 0, 0, 0, 1, 0, 0, 0, 1, 1, 1, 1, 0, 1, 0, 1, 0, 1, 1, 1, 1, 0, 1, 1, 0, 0, 1, 1, 1, 1, 1, 0, 0, 1, 0, 0, 0, 0, 1, 0, 1, 0, 1, 0, 0, 1, 1, 1, 1, 1, 0, 0, 0, 1, 0, 1, 0, 1, 0, 1, 0, 0, 0, 1, 1, 0, 0, 0, 0, 0, 1, 1, 0, 0, 1, 1, 0, 1, 0, 1, 0, 1, 1, 1, 1, 1, 0, 1, 0, 0, 1, 1, 1, 0, 1, 1, 1, 1, 1, 0, 0, 0, 0, 1, 0, 1, 1, 0, 1, 0, 1, 0, 1, 1, 1, 1, 0, 1, 1, 0, 1, 0, 1, 0, 1, 0, 1, 1, 1, 0, 1, 0, 0, 1, 0, 0, 0, 1, 1, 0, 1, 1, 0, 1, 1, 0, 1, 0, 1, 0, 0, 1, 1, 0, 1, 1, 1, 0, 0, 1, 0, 1, 1, 0, 0, 1, 0, 0, 1, 0, 1, 1, 0, 1, 1, 0, 0, 0, 0, 1, 1, 0, 0, 0, 0, 1, 0, 1, 1, 0, 1, 1, 0, 1, 1, 1, 1, 1, 0, 0, 0, 0, 0, 0, 1, 1, 0, 1, 0, 0, 1, 0, 0, 1, 0, 1, 0, 1, 1, 0, 0, 0, 0, 0, 1, 0, 0, 1, 0, 1, 0, 1, 0, 1, 1, 0, 0, 0, 1, 0, 0, 0, 0, 1, 0, 1, 0, 0, 1, 0, 1, 1, 1, 1, 1, 0, 1, 0, 0, 1, 1, 1, 1, 0, 1, 1, 1, 1, 0, 1, 0, 1, 1, 1, 0, 1, 1, 1, 1, 1, 0, 1, 1, 0, 1, 0, 1, 1, 0, 1, 1, 0, 0, 0, 1, 0, 1, 0, 0, 0, 0, 1, 0, 0, 1, 1, 0, 1, 1, 1, 1, 1, 0, 0, 1, 1, 0, 0, 1, 1, 0, 1, 0, 1, 1, 1, 1, 1, 1, 1, 0, 1, 0, 1, 1, 1, 0, 0, 0, 1, 1, 1, 0, 1, 1, 0, 0, 0, 0, 0, 0, 0, 1, 0, 0, 1, 0, 1, 0, 0, 0, 1, 1, 0, 0, 0, 1, 0, 1, 1, 0, 0, 1, 1, 0, 0, 1, 1, 1, 0, 1, 1, 1, 1, 1, 1, 1, 0, 0, 1, 0, 1, 1, 0, 0, 0, 1, 0, 1, 0, 1, 1, 0, 1, 0, 0, 1, 1, 0, 0, 1, 0, 0, 1, 1, 0, 1, 1, 1, 1, 0, 0, 0, 1, 1, 0, 0, 1, 1, 1, 0, 0, 0, 0, 1, 1, 1, 1, 0, 0, 0, 0, 1, 1, 0, 0, 1, 1, 0, 0, 1, 1, 0, 1, 1, 1, 1, 1, 1, 1, 1, 1, 0, 0, 1, 1, 0, 0, 0, 0, 0, 1, 0, 1, 1, 1, 1, 0, 1, 0, 1, 1, 1, 1, 1, 1, 1, 1, 1, 0, 1, 1, 1, 0, 0, 0, 0, 0, 1, 1, 0, 1, 0, 0, 0, 1, 0, 1, 0, 1, 0, 1, 1, 1, 0, 1, 1, 0, 0, 0, 0, 1, 1, 0, 1, 0, 0, 1, 0, 1, 1, 0, 1, 0, 1, 1, 0, 0, 1, 1, 0, 0, 1, 0, 1, 0, 1, 1, 1, 1, 1, 1, 0, 1, 0, 0, 1, 1, 1, 0, 0, 1, 1, 1, 1, 0, 1, 0, 0, 0, 1, 1, 0, 1, 1, 1, 1, 1, 1, 0, 0, 1, 0, 0, 1, 1, 0, 0, 1, 0, 1, 0, 0, 0, 1, 1, 1, 1, 0, 1, 0, 1, 1, 0, 0, 0, 1, 1, 1, 1, 0, 1, 0, 1, 0, 0, 0, 0, 1, 1, 1, 1, 0, 0, 1, 1, 1, 1, 0, 0, 1, 1, 0, 1, 1, 0, 1, 1, 0, 1, 1, 1, 0, 0, 0, 0, 0, 0, 0, 0, 1, 0, 0, 0, 1, 0, 0, 0, 0, 1, 1, 0, 1, 0, 1, 0, 1, 1, 1, 0, 1, 0, 1, 0, 0, 0, 1, 1, 0, 1, 1, 0, 0, 1, 1, 0, 0, 1, 0, 0, 0, 1, 1, 1, 1, 1, 1, 0, 0, 1, 0, 0, 0, 1, 0, 0, 1, 0, 1, 0, 0, 1, 0, 1, 0, 0, 0, 1, 0, 1, 0, 0, 1, 0, 1, 1, 0, 1, 1, 0, 1, 0, 0, 1, 1, 0, 0, 0, 0, 0, 1, 1, 0, 1, 1, 1, 0, 1, 0, 1, 0, 1, 0, 0, 1, 0, 1, 1, 0, 0, 0, 0, 1, 0, 0, 1, 1, 0, 1, 0, 1, 1, 1, 0, 0, 1, 1, 0, 1, 0, 1, 1, 0, 0, 1, 1, 1, 0, 1, 0, 1, 0, 1, 1, 1, 0, 0, 1, 1, 0, 0, 0, 1, 1, 0, 0, 1, 1, 1, 1, 0, 0, 0, 1, 1, 1, 1, 0, 1, 1, 0, 0, 0, 0, 0, 1, 1, 1, 0, 0, 1, 0, 1, 0, 1, 0, 0, 0, 0, 1, 0, 1, 0, 0, 0, 1, 1, 1, 1, 1, 1, 0, 1, 1, 0, 0, 0, 1, 0, 0, 1, 1, 0, 0, 1, 0, 0, 1, 0, 0, 1, 1, 1, 1, 0, 0, 0, 0, 0, 0, 1, 0, 1, 1, 0, 0, 1, 0, 0, 1, 1, 1, 1, 0, 1, 1, 0, 0, 0, 1, 0, 1, 1, 1, 0, 0, 1, 0, 0, 1, 1, 1, 1, 0, 0, 1, 0, 0, 0, 1, 0, 1, 1, 0, 1, 0, 0, 1, 0, 1, 1, 1, 0, 0, 1, 1, 0, 0, 0, 1, 1, 1, 0, 0, 1, 1, 1, 1, 1, 1, 0, 0, 0, 1, 1, 0, 1, 0, 0, 1, 0, 0, 0, 1, 0, 1, 1, 0, 0, 0, 1, 1, 1, 1, 1, 1, 0, 1, 0, 0, 0, 1, 0, 1, 1, 1, 1, 1, 1, 1, 1, 0, 0, 0, 1, 0, 1, 0, 0, 0, 0, 1, 0, 1, 0, 1, 0, 1, 1, 1, 0, 1, 0, 0, 1, 1, 0, 0, 1, 1, 1, 0, 1, 0, 1, 1, 1, 0, 0, 0, 0, 1, 1, 1, 0, 1, 1, 1, 0, 1, 1, 0, 0, 0, 0, 1, 0, 1, 0, 1, 1, 1, 1, 1, 1, 1, 1, 0, 0, 1, 1, 1, 0, 0, 0, 1, 0, 1, 0, 0, 0, 1, 1, 1, 1, 1, 0, 1, 0, 1, 1, 0, 0, 1, 0, 1, 1, 1, 1, 0, 1, 0, 1, 1, 1, 0, 1, 1, 0, 1, 0, 0, 1, 0, 1, 0, 0, 1, 1, 1, 0, 1, 1, 0, 1, 1, 0, 0, 1, 0, 1, 0, 0, 0, 0, 0, 1, 0, 1, 1, 1, 0, 1, 1, 0, 1, 1, 1, 1, 1, 0, 1, 0, 0, 0, 0, 1, 1, 0, 1, 1, 1, 1, 1, 1, 1, 0, 1, 0, 0, 1, 1, 0, 0, 0, 1, 1, 1, 1, 0, 1, 1, 1, 0, 0, 0, 1, 0, 1, 1, 0, 1, 0, 0, 0, 1, 1, 0, 0, 0, 1, 1, 1, 0, 0, 1, 1, 0, 0, 0, 1, 1, 0, 1, 1, 1, 1, 0, 1, 1, 0, 1, 0, 0, 1, 1, 1, 1, 0, 0, 0, 1, 1, 0, 1, 0, 1, 1, 0, 0, 0, 0, 1, 0, 1, 0, 1, 0, 1, 0, 1, 1, 1, 1, 0, 0, 0, 0, 0, 0, 1, 1, 1, 1, 0, 0, 1, 0, 0, 1, 0, 0, 1, 1, 0, 1, 0, 0, 0, 0, 0, 0, 1, 1, 0, 1, 1, 1, 1, 0, 0, 1, 0, 1, 0, 0, 1, 1, 1, 0, 1, 0, 1, 0, 1, 0, 1, 0, 0, 1, 1, 0, 0, 0, 0, 0, 0, 1, 0, 1, 1, 1, 0, 1, 0, 0, 1, 1, 1, 1, 1, 0, 1, 1, 1, 0, 1, 0, 1, 0, 1, 1, 0, 1, 0, 1, 1, 0, 0, 0, 1, 0, 0, 1, 0, 1, 0, 1, 0, 0, 1, 0, 0, 0, 1, 0, 0, 0, 1, 0, 0, 0, 1, 0, 1, 0, 1, 0, 1, 0, 1, 0, 1, 1, 0, 0, 0, 0, 0, 0, 0, 0, 1, 0, 1, 0, 1, 0, 0, 0, 0, 1, 1, 1, 0, 0, 0, 1, 1, 1, 1, 0, 0, 1, 0, 0, 0, 0, 1, 1, 0, 0, 1, 0, 0, 0, 0, 1, 0, 1, 1, 1, 0, 0, 1, 1, 1, 1, 1, 0, 0, 0, 1, 0, 1, 0, 1, 1, 0, 1, 1, 1, 0, 1, 0, 1, 0, 1, 0, 1, 0, 1, 1, 0, 1, 1, 0, 0, 0, 0, 0, 1, 1, 1, 0, 1, 0, 0, 1, 0, 1, 0, 0, 0, 1, 1, 1, 1, 0, 0, 1, 0, 1, 1, 0, 0, 0, 0, 0, 1, 0, 1, 1, 0, 1, 0, 1, 0, 1, 1, 1, 1, 0, 0, 1, 0, 0, 0, 1, 1, 1, 1, 0, 1, 0, 0, 1, 0, 0, 0, 1, 1, 1, 1, 1, 0, 0, 0, 1, 0, 0, 0, 1, 0, 1, 0, 0, 1, 0, 1, 0, 1, 1, 0, 1, 1, 0, 1, 1, 0, 0, 1, 1, 0, 0, 0, 0, 0, 0, 1, 1, 0, 0, 1, 1, 0, 0, 0, 1, 0, 1, 1, 1, 1, 1, 1, 0, 0, 1, 1, 1, 1, 1, 0, 0, 1, 0, 1, 1, 0, 1, 0, 1, 0, 1, 0, 1, 1, 0, 0, 1, 0, 0, 0, 0, 0, 1, 0, 1, 1, 0, 0, 1, 1, 0, 1, 1, 1, 1, 0, 1, 1, 1, 1, 0, 0, 1, 1, 1, 1, 0, 1, 1, 1, 0, 1, 1, 0, 1, 1, 1, 0, 1, 0, 1, 0, 0, 0, 0, 1, 0, 1, 1, 0, 0, 1, 1, 1, 1, 1, 1, 1, 0, 1, 1, 1, 0, 1, 0, 0, 0, 1, 1, 0, 1, 0, 1, 1, 1, 1, 0, 0, 1, 0, 1, 0, 1, 1, 1, 1, 0, 1, 0, 1, 0, 0, 1, 1, 1, 1, 1, 1, 0, 0, 1, 0, 1, 0, 1, 0, 0, 1, 0, 1, 0, 1, 0, 0, 0, 1, 0, 0, 1, 0, 0, 0, 1, 1, 0, 1, 0, 0, 0, 0, 0, 1, 0, 1, 1, 1, 0, 1, 0, 1, 0, 0, 0, 1, 1, 1, 1, 0, 0, 1, 0, 0, 1, 0, 1, 0, 1, 1, 0, 1, 0, 0, 1, 1, 0, 1, 0, 1, 0, 1, 1, 0, 1, 1, 0, 1, 0, 0, 0, 1, 0, 0, 0, 0, 0, 1, 1, 1, 0, 1, 0, 1, 1, 0, 1, 0, 0, 0, 1, 1, 0, 1, 0, 0, 1, 1, 1, 0, 0, 1, 0, 1, 1, 0, 1, 0, 0, 0, 1, 0, 1, 1, 0, 0, 1, 1, 1, 0, 1, 1, 1, 0, 1, 1, 1, 0, 0, 1, 0, 1, 0, 1, 0, 1, 0, 0, 1, 0, 1, 0, 0, 0, 0, 0, 1, 0, 0, 1, 0, 1, 1, 1, 0, 1, 1, 0, 0, 0, 1, 1, 1, 0, 1, 0, 0, 1, 0, 0, 0, 0, 0, 1, 1, 1, 0, 0, 0, 1, 1, 0, 1, 0, 0, 0, 0, 0, 0, 0, 1, 0, 1, 1, 1, 1, 0, 0, 0, 1, 1, 1, 1, 1, 1, 1, 0, 0, 0, 0, 0, 1, 0, 0, 0, 1, 0, 0, 1, 0, 1, 1, 0, 1, 0, 1, 0, 0, 0, 1, 1, 0, 0, 1, 0, 0, 1, 1, 0, 0, 1, 1, 1, 0, 0, 0, 1, 1, 1, 1, 1, 0, 0, 0, 0, 0, 0, 0, 1, 0, 1, 0, 0, 1, 0, 0, 0, 1, 1, 1, 0, 1, 0, 0, 0, 1, 0, 0, 0, 0, 1, 1, 1, 1, 0, 1, 0, 1, 1, 1, 0, 0, 1, 1, 1, 1, 0, 1, 0, 0, 1, 1, 0, 1, 1, 1, 0, 0, 1, 1, 1, 1, 0, 0, 1, 0, 1, 1, 0, 1, 1, 0, 1, 0, 0, 0, 1, 1, 0, 0, 0, 0, 1, 1, 1, 0, 0, 1, 1, 0, 1, 1, 0, 0, 0, 0, 1, 1, 1, 0, 0, 0, 1, 0, 1, 1, 0, 0, 0, 0, 0, 1, 1, 1, 0, 1, 0, 1, 0, 0, 1, 0, 0, 0, 1, 1, 0, 0, 1, 0, 0, 0, 1, 0, 0, 1, 1, 1, 0, 0, 1, 0, 1, 0, 0, 1, 0, 0, 0, 1, 0, 1, 0, 1, 0, 0, 1, 0, 1, 1, 0, 0, 0, 1, 1, 0, 1, 1, 1, 0, 1, 0, 0, 0, 1, 0, 0, 1, 0, 1, 1, 1, 0, 1, 0, 0, 0, 1, 1, 1, 1, 1, 1, 1, 1, 0, 0, 0, 1, 0, 0, 0, 0, 0, 1, 0, 0, 0, 1, 0, 1, 1, 0, 1, 1, 0, 1, 0, 1, 1, 1, 0, 0, 0, 0, 0, 1, 0, 1, 1, 0, 0, 0, 1, 0, 1, 1, 1, 1, 0, 1, 0, 1, 1, 1, 1, 1, 1, 1, 0, 1, 0, 1, 0, 1, 0, 0, 0, 0, 1, 1, 1, 0, 0, 1, 1, 0, 1, 0, 0, 0, 0, 1, 1, 0, 0, 1, 1, 1, 1, 1, 1, 1, 1, 1, 1, 0, 1, 0, 0, 1, 1, 0, 1, 1, 1, 1, 0, 1, 0, 1, 1, 0, 0, 0, 1, 1, 0, 0, 1, 1, 0, 0, 1, 1, 1, 1, 1, 1, 1, 1, 1, 1, 1, 0, 1, 0, 0, 0, 0, 0, 0, 0, 1, 1, 1, 1, 1, 1, 0, 0, 0, 1, 0, 0, 1, 0, 0, 1, 0, 1, 0, 0, 0, 0, 0, 1, 1, 0, 1, 1, 0, 0, 0, 1, 1, 1, 0, 0, 1, 0, 1, 0, 0, 0, 0, 0, 0, 1, 0, 1, 0, 1, 1, 1, 0, 0, 1, 1, 1, 0, 0, 1, 1, 0, 1, 1, 0, 0, 1, 1, 1, 1, 1, 0, 1, 1, 0, 0, 0, 0, 1, 0, 0, 0, 0, 1, 0, 0, 1, 1, 1, 0, 1, 1, 0, 1, 0, 0, 1, 0, 0, 1, 0, 1, 1, 0, 1, 0, 0, 0, 0, 1, 1, 1, 0, 1, 1, 1, 1, 1, 0, 0, 0, 1, 1, 0, 1, 0, 0, 1, 1, 0, 0, 1, 0, 1, 1, 0, 0, 1, 0, 0, 0, 1, 0, 0, 1, 1, 0, 0, 1, 1, 1, 1, 0, 0, 1, 1, 1, 1, 1, 0, 1, 0, 1, 1, 0, 1, 0, 1, 1, 0, 0, 0, 0, 0, 0, 1, 0, 1, 0, 1, 0, 1, 0, 0, 1, 1, 1, 0, 0, 0, 0, 0, 1, 0, 1, 0, 1, 0, 0, 1, 0, 1, 1, 1, 0, 1, 1, 1, 1, 1, 1, 1, 0, 1, 0, 1, 0, 0, 1, 1, 1, 1, 0, 1, 0, 1, 0, 1, 1, 0, 0, 0, 1, 1, 0, 0, 0, 1, 0, 1, 0, 0, 0, 1, 1, 0, 0, 1, 1, 0, 1, 1, 0, 0, 1, 1, 1, 1, 1, 0, 0, 0, 1, 1, 1, 0, 1, 0, 1, 0, 0, 0, 0, 0, 1, 1, 0, 01, 0, 0, 0, 0, 0, 1, 1, 0, 0, 0, 1, 1, 1, 1, 1, 0, 0, 0, 1, 1, 1, 0, 0, 1, 1, 1, 0, 1, 0, 0, 0, 0, 1, 0, 1, 1, 0, 1, 1, 1, 0, 1, 1, 1, 1, 1, 1, 0, 0, 1, 1, 0, 1, 1, 0, 0, 1, 0, 1, 1, 1, 0, 0, 1, 1, 0, 1, 1, 1, 0, 0, 0, 0, 0, 1, 0, 0, 0, 0, 0, 1, 1, 0, 0, 0, 0, 0, 0, 1, 0, 1, 1, 1, 0, 1, 1, 0, 1, 1, 1, 1, 0, 1, 1, 0, 1, 1, 1, 0, 0, 1, 1, 0, 0, 0, 0, 1, 0, 0, 1, 1, 1, 1, 0, 1, 1, 1, 0, 0, 1, 0, 1, 1, 1, 0, 1, 0, 0, 1, 0, 1, 1, 0, 1, 1, 0, 0, 1, 1, 1, 0, 1, 1, 0, 10, 0, 1, 0, 0, 1, 0, 1, 1, 1, 1, 1, 1, 1, 0, 1, 1, 1, 1, 0, 0, 0, 0, 1, 1, 0, 1, 1, 1, 0, 0, 1, 1, 0, 1, 0, 0, 1, 0, 0, 1, 1, 1, 0, 1, 1, 0, 0, 0, 0, 1, 0, 0, 1, 0, 0, 1, 0, 1, 1, 1, 0, 0, 0, 0, 0, 0, 1, 1, 1, 0, 0, 0, 1, 0, 0, 1, 0, 0, 0, 0, 0, 0, 1, 0, 0, 0, 0, 1, 1, 0, 0, 1, 1, 0, 1, 0, 1, 0, 1, 1, 0, 1, 1, 0, 0, 1, 0, 1, 0, 1, 1, 0, 1, 0, 1, 0, 1, 0, 0, 1, 0, 0, 1, 0, 0, 0, 0, 1, 0, 0, 0, 0, 0, 0, 1, 1, 1, 1, 0, 1, 1, 0, 0, 1, 0, 0, 1, 1, 1, 0, 0, 1, 1, 0, 0, 0, 1, 0, 0, 0, 1, 1, 1, 1, 0, 0, 1, 0, 1, 0, 0, 0, 1, 1, 0, 1, 0, 1, 0, 1, 1, 0, 0, 1, 0, 1, 0, 0, 0, 1, 0, 1, 1, 0, 1, 0, 1, 1, 0, 1, 1, 1, 0, 0, 1, 0, 1, 0, 0, 0, 1, 0, 0, 1, 0, 1, 0, 1, 1, 0, 1, 0, 0, 0, 1, 0, 0, 1, 0, 0, 1, 1, 1, 0, 1, 0, 0, 0, 0, 0, 1, 0, 0, 1, 1, 1, 1, 1, 0, 1, 1, 0, 0, 1, 0, 1, 0, 1, 1, 0, 0, 1, 1, 0, 1, 0, 0, 1, 0, 1, 1, 1, 1, 0, 1, 1, 0, 0, 1, 1, 1, 1, 1, 1, 0, 0, 1, 1, 1, 0, 1, 0, 0, 1, 0, 1, 1, 0, 0, 1, 1, 1, 0, 0, 1, 1, 0, 1, 1, 1, 0, 0, 0, 1, 1, 1, 0, 0, 1, 0, 0, 0, 0, 0, 0, 0, 0, 1, 0, 0, 1, 1, 0, 0, 0, 0, 1, 1, 0, 0, 1, 1, 1, 0, 1, 1, 0, 1, 1, 1, 1, 0, 0, 1, 0, 0, 0, 0, 1, 1, 1, 0, 1, 0, 0, 1, 1, 1, 0, 0, 0, 1, 1, 1, 0, 1, 0, 0, 0, 0, 0, 0, 0, 0, 1, 1, 1, 1, 1, 0, 0, 0, 0, 1, 0, 0, 1, 0, 1, 0, 0, 1, 1, 1, 0, 0, 0, 1, 0, 1, 0, 1, 0, 0, 0, 0, 0, 1, 1, 0, 0, 0, 1, 1, 1, 0, 1, 0, 1, 1, 0, 0, 0, 0, 0, 1, 1, 0, 1, 0, 1, 0, 1, 0, 1, 0, 1, 0, 1, 0, 0, 0, 0, 0, 0, 0, 0, 0, 0, 1, 1, 1, 0, 0, 0, 0, 0, 0, 1, 0, 0, 0, 0, 0, 1, 0, 0, 1, 1, 0, 1, 1, 0, 1, 1, 0, 0, 1, 1, 0, 0, 0, 0, 0, 0, 1, 1, 1, 1, 1, 0, 1, 0, 0, 1, 0, 0, 1, 0, 1, 1, 1, 1, 0, 0, 0, 0, 0, 1, 1, 1, 1, 1, 0, 0, 1, 0, 1, 0, 0, 1, 0, 1, 0, 1, 0, 1, 0, 1, 0, 0, 1, 0, 0, 0, 0, 0, 0, 0, 1, 0, 0, 0, 1, 1, 0, 0, 0, 1, 1, 0, 1, 0, 0, 1, 1, 0, 0, 0, 1, 0, 1, 1, 0, 1, 1, 1, 0, 0, 1, 1, 1, 0, 0, 0, 1, 0, 0, 1, 1, 0, 0, 0, 0, 0, 1, 0, 0, 1, 1, 1, 0, 1, 0, 1, 1, 0, 0, 1, 0, 0, 1, 1, 0, 1, 0, 1, 1, 0, 0, 0, 1, 1, 0, 1, 0, 1, 0, 1, 0, 0, 0, 1, 0, 1, 0, 0, 0, 0, 1, 1, 0, 1, 1, 0, 1, 1, 1, 1, 0, 1, 0, 0, 0, 0, 0, 1, 1, 1, 1, 1, 1, 1, 0, 1, 0, 0, 1, 0, 0, 0, 0, 1, 1, 1, 1, 0, 0, 0, 1, 1, 1, 0, 0, 1, 1, 0, 0, 0, 0, 0, 0, 0, 1, 1, 0, 1, 1, 0, 0, 0, 1, 0, 0, 1, 1, 0, 1, 1, 1, 0, 1, 0, 0, 1, 0, 1, 0, 0, 1, 1, 1, 1, 0, 0, 0, 1, 0, 1, 0, 0, 1, 1, 0, 1, 0, 1, 0, 0, 0, 1, 0, 0, 1, 0, 0, 1, 1, 1, 1, 1, 0, 0, 1, 0, 0, 1, 0, 1, 0, 0, 1, 0, 0, 1, 0, 1, 1, 1, 0, 1, 0, 0, 1, 1, 1, 0, 0, 0, 0, 1, 0, 0, 1, 0, 0, 0, 0, 1, 1, 1, 0, 0, 0, 0, 1, 1, 1, 0, 0, 0, 0, 0, 1, 1, 0, 0, 0, 0, 0, 1, 0, 1, 0, 1, 1, 0, 1, 0, 1, 1, 1, 0, 0, 1, 0, 0, 1, 0, 1, 1, 0, 0, 0, 1, 1, 0, 0, 0, 1, 0, 1, 1, 1, 1, 1, 0, 1, 0, 0, 0, 1, 1, 1, 0, 0, 1, 1, 1, 1, 0, 0, 0, 0, 0, 0, 0, 1, 0, 0, 1, 1, 0, 1, 0, 0, 0, 1, 1, 1, 0, 0, 1, 0, 0, 1, 0, 1, 1, 1, 0, 0, 1, 1, 1, 0, 1, 1, 1, 0, 0, 1, 1, 0, 0, 1, 0, 1, 0, 0, 1, 1, 1, 1, 1, 0, 1, 0, 1, 0, 1, 0, 1, 1, 1, 0, 0, 0, 0, 0, 0, 1, 1, 0, 0, 0, 1, 0, 0, 0, 1, 0, 1, 1, 0, 0, 1, 0, 1, 0, 1, 1, 1, 0, 1, 1, 0, 1, 0, 0, 1, 1, 0, 1, 0, 0, 0, 1, 1, 0, 1, 1, 0, 1, 1, 1, 0, 0, 1, 0, 0, 0, 1, 0, 1, 0, 1, 1, 0, 1, 1, 1, 0, 0, 0, 0, 0, 1, 1, 0, 0, 0, 1, 0, 1, 0, 1, 0, 1, 1, 0, 0, 1, 1, 0, 0, 0, 0, 1, 0, 1, 1, 1, 1, 1, 0, 1, 1, 1, 1, 1, 1, 1, 0, 1, 1, 0, 1, 1, 0, 0, 0, 1, 1, 0, 0, 0, 0, 0, 1, 0, 0, 0, 1, 1, 0, 1, 0, 1, 1, 0, 1, 0, 0, 1, 0, 1, 0, 1, 0, 0, 1, 1, 0, 0, 1, 0, 0, 0, 1, 0, 1, 1, 1, 1, 0, 0, 1, 0, 1, 1, 1, 1, 1, 1, 0, 1, 0, 1, 1, 1, 1, 0, 0, 1, 1, 1, 0, 1, 1, 1, 1, 0, 1, 1, 0, 0, 1, 0, 1, 1, 1, 1, 0, 0, 1, 1, 0, 1, 1, 1, 1, 1, 0, 1, 1, 1, 0, 0, 1, 1, 0, 1, 1, 0, 1, 0, 0, 1, 1, 1, 0, 0, 0, 0, 1, 1, 0, 1, 0, 0, 0, 0, 1, 1, 0, 1, 0, 1, 1, 1, 1, 1, 0, 1, 0, 1, 0, 1, 1, 1, 0, 1, 1, 1, 0, 0, 0, 1, 1, 0, 1, 0, 1, 0, 0, 0, 0, 1, 0, 1, 0, 0, 1, 1, 1, 0, 1, 1, 1, 0, 1, 0, 1, 0, 0, 1, 0, 1, 0, 1, 1, 0, 0, 1, 0, 0, 1, 0, 0, 1, 0, 1, 1, 0, 0, 0, 0, 0, 0, 0, 1, 1, 0, 1, 0, 1, 0, 0, 0, 1, 0, 1, 0, 1, 0, 0, 1, 1, 0, 1, 1, 0, 0, 0, 1, 0, 1, 1, 0, 0, 0, 1, 0, 0, 1, 1, 1, 0, 1, 0, 0, 1, 0, 0, 1, 0, 0, 1, 1, 1, 0, 0, 0, 0, 0, 0, 0, 1, 0, 0, 0, 0, 1, 0, 0, 0, 1, 1, 0, 1, 1, 1, 1, 0, 1, 0, 0, 1, 0, 0, 1, 1, 1, 1, 1, 1, 0, 0, 0, 0, 1, 0, 1, 0, 0, 1, 0, 0, 1, 1, 1, 1, 0, 1, 0, 0, 0, 0, 1, 0, 1, 1, 1, 1, 1, 1, 1, 1, 1, 1, 1, 1, 1]

In step 2, the first set is a set of all odd numbers less than or equal to 2¹³−1. For example, the first set includes L sampling values, and the sequence s is separately sampled by using the L sampling values in the first set, to obtain the L sampling sequences whose lengths are N.

In step 3, the second threshold is −28 dB, M=16 sampling sequences are selected, based on the second threshold, from the L sampling sequences whose lengths are N, and a cross-correlation between any two sequences in the 16 sequences is less than or equal to the second threshold. In this case, the 16 generated sequences correspond to 16 sampling values d={3047, 229, 511, 1645, 311, 1259, 1919, 847, 1437, 2047, 421, 1255, 1277, 2007, 101, 3055}, and 16 sequences in a generated sequence set are shown in Table 2. It should be understood that the 16 sequences in Table 2 are sequences generated after a bit whose value is 0 in a sampling sequence corresponding to the sampling values is mapped onto a positive pulse (that is, mapped onto 1), and a bit whose value is 1 is mapped onto a negative pulse (that is, mapped onto −1).

TABLE 2

| Sequence | |
|---|---|
| number | Sequence value |
| 1 | −1 −1 −1 −1 −1 −1 −1 −1 −1 −1 −1 −1 −1 1 1 −1 −1 1 −1 1 −1 1 −1 −1 1 1 1 1 1 1 |
| | −1 −1 −1 1 −1 1 −1 1 1 1 1 1 1 1 −1 −1 −1 1 −1 1 1 1 −1 1 −1 −1 −1 −1 1 1 −1 −1 |
| | −1 1 1 1 −1 −1 −1 −1 1 1 −1 −1 1 −1 −1 1 1 1 −1 1 −1 −1 −1 −1 1 −1 1 1 1 −1 1 1 |
| | −1 −1 −1 1 −1 −1 −1 −1 1 −1 1 −1 1 −1 −1 1 −1 −1 1 −1 1 −1 1 1 −1 1 1 −1 −1 −1 |
| | 1 1 1 −1 −1 1 1 −1 −1 1 −1 1 −1 −1 1 −1 −1 1 1 −1 −1 −1 1 −1 −1 −1 1 1 −1 1 −1 |
| | −1 −1 −1 1 −1 −1 −1 1 1 1 1 −1 1 1 −1 1 1 −1 1 −1 1 1 −1 1 1 1 −1 1 −1 −1 |
| | 1 1 −1 1 1 1 −1 −1 −1 −1 −1 −1 −1 −1 −1 1 −1 1 −1 −1 −1 1 1 −1 1 1 1 1 −1 −1 1 |
| | 1 −1 1 1 −1 1 1 1 −1 −1 1 −1 1 1 1 −1 1 1 −1 1 1 −1 1 1 −1 −1 1 −1 1 1 −1 1 −1 1 |
| | −1 −1 −1 1 1 1 1 1 −1 1 −1 −1 −1 −1 1 1 −1 1 −1 −1 1 −1 1 1 1 1 −1 1 1 −1 1 −1 |
| | −1 1 −1 1 −1 −1 1 1 1 1 1 −1 1 1 1 −1 −1 1 −1 1 1 −1 −1 −1 1 1 −1 −1 1 −1 −1 −1 |
| | 1 1 −1 1 1 −1 −1 −1 1 1 1 1 −1 −1 1 1 1 −1 1 −1 1 −1 −1 −1 −1 1 1 −1 1 −1 1 1 1 1 |
| | −1 −1 −1 1 −1 −1 −1 −1 −1 −1 1 −1 1 1 −1 1 −1 −1 −1 −1 1 1 1 1 −1 −1 1 1 1 1 1 |
| | 1 1 1 1 1 1 −1 −1 −1 −1 −1 1 1 1 1 1 −1 −1 −1 1 1 1 1 −1 −1 1 −1 1 1 1 1 −1 1 1 1 |
| | 1 1 −1 −1 1 −1 1 1 −1 1 −1 1 1 −1 1 1 −1 −1 −1 −1 1 −1 −1 1 −1 −1 1 1 −1 −1 −1 |
| | −1 −1 1 −1 −1 −1 1 −1 1 1 −1 1 1 −1 1 1 −1 1 −1 1 −1 −1 −1 1 −1 1 −1 1 1 −1 1 1 |
| | 1 1 1 −1 −1 1 −1 −1 1 1 1 1 −1 −1 1 −1 −1 −1 1 −1 −1 1 −1 −1 −1 −1 −1 −1 −1 1 1 |
| | 1 −1 −1 1 −1 −1 −1 −1 −1 1 −1 1 −1 1 −1 −1 −1 1 1 −1 1 1 −1 1 1 −1 −1 −1 1 −1 |
| | −1 1 1 −1 1 −1 −1 1 −1 −1 1 1 1 −1 −1 1 −1 1 −1 1 1 −1 −1 −1 −1 1 −1 1 −1 −1 1 |
| | 1 1 1 1 1 1 −1 1 1 1 −1 1 −1 −1 −1 1 −1 1 1 −1 −1 −1 −1 −1 1 −1 −1 1 −1 1 −1 −1 |
| | −1 1 1 −1 1 −1 1 −1 −1 1 −1 −1 1 −1 −1 −1 −1 1 1 −1 −1 1 1 1 1 −1 1 −1 −1 1 1 1 |
| | −1 1 1 −1 1 1 −1 −1 −1 1 1 −1 −1 1 1 −1 1 1 −1 1 −1 −1 1 1 −1 −1 1 1 1 −1 −1 −1 |
| | 1 1 1 −1 1 −1 1 −1 −1 −1 1 1 −1 −1 −1 1 −1 −1 −1 −1 −1 1 −1 1 −1 −1 −1 1 −1 −1 |
| | −1 1 −1 −1 1 1 −1 −1 −1 −1 1 −1 1 1 1 1 −1 1 1 −1 −1 −1 1 1 1 −1 1 1 −1 −1 1 −1 |
| | 1 −1 1 1 1 1 −1 1 1 −1 −1 1 1 −1 1 1 −1 −1 1 1 −1 −1 −1 −1 1 1 1 1 1 1 1 1 1 −1 |
| | −1 1 1 1 −1 −1 1 1 1 −1 −1 1 −1 −1 1 1 −1 −1 −1 1 1 −1 1 1 −1 1 −1 1 1 1 −1 −1 |
| | −1 1 1 −1 −1 1 1 1 −1 −1 1 −1 −1 −1 1 1 −1 1 −1 −1 1 −1 −1 −1 −1 −1 1 1 1 −1 1 |
| | −1 1 −1 1 1 −1 −1 1 −1 −1 1 −1 −1 1 1 1 1 −1 1 −1 1 1 1 1 −1 −1 1 −1 1 1 1 −1 −1 |
| | −1 1 −1 −1 −1 1 1 −1 −1 −1 1 −1 1 −1 1 −1 −1 1 −1 1 1 1 1 1 −1 −1 1 −1 −1 −1 1 |
| | −1 1 1 1 −1 1 1 1 1 1 −1 1 −1 −1 −1 1 −1 −1 1 −1 −1 −1 1 −1 1 −1 −1 −1 −1 1 1 |
| | −1 −1 1 −1 −1 −1 1 −1 −1 −1 1 1 1 1 −1 −1 −1 1 1 −1 1 1 1 −1 −1 −1 1 1 1 1 1 −1 |
| | 1 −1 1 −1 1 1 −1 1 −1 1 1 −1 −1 −1 1 1 1 −1 1 −1 −1 1 1 1 −1 1 −1 −1 −1 1 1 1 1 |
| | −1 −1 1 −1 −1 1 −1 1 1 −1 −1 −1 −1 −1 −1 1 1 −1 1 1 −1 −1 −1 1 −1 1 −1 −1 1 −1 |
| | −1 −1 1 −1 −1 −1 −1 −1 −1 −1 1 −1 −1 1 1 −1 −1 −1 −1 −1 −1 −1 1 −1 −1 1 −1 −1 |
| | 1 −1 1 1 1 1 −1 1 −1 −1 −1 −1 1 −1 1 −1 1 1 1 −1 1 1 1 −1 1 −1 1 −1 1 −1 1 −1 −1 |
| | −1 −1 −1 1 1 −1 1 1 −1 1 1 −1 1 −1 −1 −1 1 −1 −1 1 −1 1 −1 −1 −1 −1 1 1 1 1 −1 |
| | 1 1 −1 1 −1 −1 −1 −1 −1 −1 1 −1 −1 −1 −1 −1 −1 −1 1 1 −1 −1 1 1 1 1 1 1 1 −1 −1 |
| | −1 −1 1 −1 −1 −1 −1 1 −1 −1 −1 1 −1 −1 −1 −1 −1 1 −1 −1 −1 1 −1 −1 1 1 1 −1 1 |
| | −1 −1 1 −1 −1 −1 −1 −1 −1 1 −1 −1 −1 1 −1 1 −1 −1 −1 1 1 −1 −1 1 −1 1 1 1 −1 |
| | −1 1 −1 1 1 1 1 1 −1 −1 −1 −1 1 −1 −1 1 −1 −1 −1 1 1 −1 1 1 1 −1 1 1 −1 −1 −1 1 |
| | 1 −1 1 −1 −1 1 −1 1 −1 1 −1 −1 −1 −1 1 −1 1 1 1 1 1 −1 −1 1 1 −1 1 1 1 −1 −1 −1 |
| | 1 −1 1 −1 1 1 −1 1 −1 1 −1 1 1 1 −1 1 1 −1 1 −1 1 −1 −1 1 −1 1 −1 1 1 1 −1 1 1 −1 |
| | −1 −1 −1 −1 1 −1 1 −1 1 −1 1 −1 −1 1 1 −1 −1 1 −1 −1 −1 1 −1 1 −1 −1 1 −1 −1 1 |
| | 1 1 −1 1 1 1 1 1 −1 −1 1 1 1 −1 −1 −1 1 −1 −1 1 −1 1 1 −1 −1 −1 1 −1 1 1 −1 1 −1 |
| | −1 1 1 −1 −1 −1 1 −1 −1 1 1 −1 −1 −1 1 1 1 1 −1 −1 −1 1 −1 −1 −1 1 −1 1 1 1 −1 |
| | −1 1 −1 1 −1 1 −1 1 1 1 1 1 −1 1 −1 −1 −1 −1 −1 1 1 1 1 1 −1 1 −1 −1 1 −1 −1 1 1 |
| | −1 1 1 −1 1 1 −1 1 1 −1 1 1 1 1 −1 1 −1 1 −1 1 −1 1 1 1 1 1 1 1 1 −1 1 1 1 −1 −1 |
| | −1 1 −1 −1 1 −1 −1 1 1 −1 1 −1 1 −1 −1 1 1 1 −1 1 1 −1 −1 1 1 −1 1 −1 −1 1 1 −1 |
| | 1 1 1 1 −1 1 −1 1 1 1 1 1 −1 −1 −1 −1 −1 −1 1 1 1 1 1 −1 −1 1 1 −1 1 −1 1 1 −1 1 |
| | −1 1 −1 1 −1 1 1 1 −1 1 −1 1 −1 1 −1 −1 −1 1 −1 1 1 −1 −1 1 −1 1 1 1 1 −1 1 −1 1 |
| | −1 1 1 1 −1 1 −1 −1 −1 −1 −1 1 1 −1 1 −1 −1 −1 1 1 −1 1 1 1 −1 −1 1 1 −1 1 −1 |
| | −1 1 −1 1 −1 −1 −1 1 −1 1 −1 1 −1 −1 −1 1 −1 −1 −1 1 1 −1 −1 1 1 1 1 1 −1 1 1 |
| | −1 1 1 −1 1 1 1 −1 −1 −1 −1 −1 1 −1 1 −1 −1 1 −1 1 1 1 1 −1 −1 1 1 1 1 1 −1 1 −1 |
| | 1 −1 −1 1 1 1 1 −1 −1 1 1 1 1 −1 1 −1 1 −1 −1 −1 1 1 1 −1 1 1 1 1 1 1 1 −1 −1 −1 |
| | −1 −1 −1 1 −1 1 −1 1 1 1 −1 −1 1 −1 −1 −1 1 −1 1 −1 1 1 1 −1 −1 −1 −1 1 −1 −1 1 |
| | −1 1 −1 −1 1 1 −1 −1 −1 1 −1 1 1 −1 −1 1 1 −1 −1 −1 −1 −1 1 −1 1 −1 −1 −1 −1 |
| | −1 1 −1 −1 1 1 −1 −1 1 −1 1 −1 1 −1 1 1 −1 1 −1 −1 −1 1 1 1 1 1 1 −1 1 1 1 −1 1 1 |
| | −1 1 1 1 −1 −1 1 1 1 −1 1 1 −1 −1 1 −1 −1 −1 −1 1 −1 −1 1 −1 −1 1 −1 −1 1 −1 1 |
| | 1 −1 1 1 1 1 1 1 1 −1 1 1 1 1 1 1 −1 1 −1 1 −1 −1 1 −1 1 −1 −1 1 −1 −1 −1 −1 1 1 |
| | 1 1 −1 −1 −1 1 −1 1 −1 −1 −1 −1 −1 −1 1 1 −1 −1 −1 −1 1 −1 1 1 −1 1 1 1 −1 1 1 |
| | 1 −1 −1 1 1 1 1 −1 −1 1 1 1 −1 −1 −1 −1 −1 1 1 1 −1 −1 1 1 1 1 1 1 1 −1 1 −1 1 1 |
| | 1 1 1 1 −1 1 −1 1 1 −1 −1 −1 −1 1 1 −1 1 1 −1 1 1 1 1 1 −1 1 −1 1 1 −1 1 1 1 −1 |
| | −1 −1 1 1 −1 1 −1 −1 −1 1 −1 1 −1 −1 −1 −1 −1 1 1 −1 −1 1 1 1 −1 1 −1 1 1 1 1 1 |
| | −1 1 −1 1 −1 1 −1 −1 −1 −1 −1 −1 1 1 1 −1 1 −1 −1 1 −1 −1 1 −1 1 −1 −1 1 1 1 −1 |
| | 1 1 1 −1 −1 1 1 −1 1 1 −1 −1 −1 −1 1 1 1 −1 1 1 1 1 −1 −1 −1 1 1 −1 −1 −1 −1 1 1 |
| | −1 1 1 1 1 −1 1 −1 −1 1 −1 1 −1 1 1 1 1 1 −1 −1 1 1 1 1 −1 1 1 1 1 −1 1 −1 −1 −1 |
| | 1 −1 1 −1 1 1 1 1 −1 1 −1 −1 1 1 −1 1 −1 −1 1 1 1 −1 −1 −1 −1 −1 1 −1 1 1 −1 −1 |
| | −1 −1 −1 −1 −1 1 1 1 −1 1 1 1 −1 1 1 1 −1 1 −1 −1 −1 −1 −1 −1 1 1 1 1 1 1 −1 −1 |
| | 1 1 −1 1 −1 −1 1 1 1 1 −1 1 −1 1 −1 1 −1 −1 1 −1 1 −1 −1 −1 −1 1 −1 1 −1 −1 −1 |
| | −1 1 −1 1 1 −1 1 −1 −1 1 −1 −1 1 −1 −1 1 1 −1 −1 1 −1 1 1 1 1 1 −1 1 −1 1 1 1 1 |
| | −1 1 1 1 1 −1 −1 1 1 1 −1 −1 1 −1 1 1 −1 −1 1 1 −1 −1 1 −1 1 1 1 −1 1 1 1 1 −1 −1 |
| | −1 −1 1 1 −1 1 1 −1 −1 1 −1 1 −1 1 −1 1 −1 −1 −1 −1 1 1 −1 −1 −1 −1 1 −1 −1 1 1 |
| | 1 −1 −1 1 −1 −1 −1 −1 1 1 1 1 1 −1 1 1 1 −1 1 1 1 1 −1 1 1 1 −1 −1 −1 1 1 −1 −1 |
| | −1 1 −1 −1 1 −1 1 1 1 −1 1 1 1 −1 −1 1 −1 1 −1 −1 1 −1 −1 −1 1 1 −1 1 −1 1 1 1 |
| | −1 1 1 1 −1 −1 −1 −1 −1 −1 1 −1 1 1 1 −1 1 1 1 −1 1 1 1 1 1 1 −1 1 1 1 1 −1 −1 1 |
| | −1 1 1 −1 −1 1 −1 −1 1 1 1 −1 −1 −1 1 −1 1 −1 1 −1 −1 −1 −1 −1 1 −1 −1 −1 1 1 |
| | −1 −1 1 −1 1 −1 1 1 −1 −1 1 −1 −1 −1 −1 1 1 −1 −1 −1 1 −1 1 1 −1 1 1 −1 −1 1 1 |
| | 1 1 −1 1 1 1 −1 −1 −1 −1 1 1 −1 1 −1 1 1 −1 1 1 −1 1 −1 1 1 1 1 −1 1 1 −1 1 1 −1 |
| | −1 −1 −1 1 1 −1 −1 −1 1 −1 −1 1 1 1 −1 1 1 −1 −1 −1 1 1 1 1 1 −1 −1 1 −1 1 −1 1 |
| | −1 1 −1 1 −1 1 1 −1 1 1 1 1 −1 −1 1 1 1 1 −1 −1 −1 −1 −1 1 1 −1 −1 −1 1 1 −1 1 1 |
| | 1 1 1 1 −1 −1 1 1 1 −1 1 1 −1 1 1 1 −1 1 1 −1 1 1 −1 −1 1 1 −1 −1 1 −1 −1 1 −1 −1 |
| | −1 −1 −1 −1 1 1 −1 1 1 1 −1 1 1 1 −1 1 1 −1 1 −1 1 1 −1 −1 −1 −1 1 −1 −1 −1 1 1 |
| | −1 −1 −1 −1 −1 −1 −1 −1 1 1 −1 1 −1 1 −1 1 1 −1 −1 1 1 −1 −1 −1 1 −1 −1 −1 −1 |
| | 1 1 1 1 1 1 1 −1 1 1 −1 −1 −1 −1 1 1 −1 1 −1 −1 −1 1 −1 −1 −1 1 −1 1 1 −1 −1 1 1 |
| | 1 −1 1 −1 1 −1 1 −1 1 1 −1 1 −1 1 −1 −1 1 −1 −1 −1 −1 1 −1 1 −1 −1 1 1 −1 1 −1 |
| | 1 −1 1 −1 −1 −1 1 1 1 −1 −1 1 −1 1 −1 −1 −1 1 1 1 −1 1 −1 1 −1 1 −1 −1 1 1 1 1 |
| | −1 1 1 −1 1 −1 1 −1 1 −1 1 −1 1 1 1 1 −1 1 −1 1 1 −1 −1 −1 1 1 −1 −1 −1 −1 1 −1 |
| | −1 −1 1 −1 −1 1 −1 1 1 1 1 1 −1 1 1 1 −1 1 −1 1 −1 −1 −1 −1 −1 1 1 1 1 −1 −1 −1 |
| | −1 1 −1 1 1 −1 −1 −1 −1 1 −1 1 1 −1 −1 1 −1 −1 −1 −1 −1 1 1 −1 1 −1 1 −1 −1 1 1 |
| | −1 −1 −1 1 1 1 −1 −1 1 −1 −1 1 1 1 −1 1 1 −1 1 −1 −1 1 −1 −1 −1 1 1 −1 −1 −1 −1 |
| | 1 −1 1 −1 −1 −1 1 −1 1 −1 −1 −1 1 −1 −1 1 1 1 −1 −1 −1 1 1 1 1 1 1 1 1 1 1 −1 −1 |
| | 1 −1 1 1 −1 −1 −1 −1 1 1 −1 −1 1 1 1 −1 −1 −1 −1 1 −1 −1 −1 1 −1 1 1 1 1 −1 −1 |
| | −1 −1 1 −1 1 −1 −1 1 −1 1 −1 1 −1 −1 1 −1 −1 −1 −1 −1 −1 −1 −1 1 −1 −1 1 −1 1 |
| | 1 1 1 −1 −1 −1 1 −1 1 −1 1 −1 1 −1 1 −1 −1 1 1 1 −1 −1 −1 1 1 −1 1 −1 1 −1 −1 |
| | −1 −1 1 1 1 1 1 1 −1 −1 −1 1 1 1 1 1 −1 −1 −1 −1 −1 −1 −1 1 −1 1 −1 1 1 −1 −1 1 |
| | 1 1 1 1 −1 1 −1 −1 −1 1 1 −1 −1 −1 1 1 −1 1 −1 1 −1 1 −1 1 1 −1 −1 −1 −1 −1 1 |
| | −1 1 1 1 1 1 1 1 −1 −1 1 1 1 1 −1 −1 1 −1 1 1 −1 1 1 1 −1 −1 −1 −1 1 1 1 1 1 1 −1 |
| | 1 −1 −1 1 −1 −1 −1 1 1 1 −1 1 −1 −1 1 −1 1 1 1 1 1 1 −1 −1 −1 1 1 −1 1 −1 −1 1 1 |
| | 1 1 1 1 1 1 1 −1 1 1 −1 1 1 1 −1 −1 −1 1 −1 −1 −1 −1 1 1 −1 1 −1 1 −1 1 −1 −1 1 1 |
| | −1 1 1 1 −1 1 −1 1 −1 1 1 1 1 −1 1 1 1 −1 −1 1 1 −1 −1 1 1 −1 1 1 −1 −1 −1 1 1 −1 |
| | 1 1 −1 −1 −1 −1 1 −1 1 1 1 −1 −1 −1 1 1 1 1 −1 −1 −1 −1 −1 1 −1 −1 1 −1 −1 −1 1 |
| | −1 −1 −1 1 −1 1 −1 −1 1 1 −1 −1 1 −1 1 −1 −1 −1 −1 1 1 −1 1 1 1 −1 1 −1 1 1 1 |
| | −1 1 −1 1 −1 −1 −1 1 −1 −1 1 −1 −1 1 1 1 1 1 1 1 1 −1 −1 −1 1 1 −1 −1 −1 1 1 −1 |
| | −1 −1 −1 −1 −1 1 −1 −1 1 1 −1 1 −1 1 −1 1 1 −1 1 1 −1 −1 1 1 −1 1 1 1 −1 −1 1 1 |
| | 1 1 1 −1 −1 1 −1 1 1 1 1 1 1 −1 1 −1 −1 1 1 −1 1 1 −1 −1 1 −1 1 1 1 1 1 1 1 1 1 −1 |
| | −1 −1 1 −1 −1 1 −1 −1 −1 1 1 1 1 −1 1 1 −1 −1 1 1 1 1 −1 −1 1 −1 −1 1 1 1 −1 −1 |
| | 1 1 1 1 1 −1 1 1 1 1 −1 −1 −1 −1 −1 1 1 1 −1 1 1 −1 1 −1 −1 −1 −1 1 −1 −1 −1 1 1 |
| | 1 1 1 1 1 −1 −1 −1 1 1 1 −1 1 1 −1 1 1 1 1 1 −1 −1 −1 −1 1 1 −1 −1 −1 1 1 −1 −1 1 |
| | −1 1 −1 −1 1 1 −1 −1 1 1 1 1 −1 1 1 −1 −1 1 −1 1 −1 −1 1 −1 1 1 −1 −1 1 1 −1 1 1 |
| | 1 1 −1 −1 1 −1 −1 −1 1 1 −1 −1 −1 1 1 1 1 1 1 1 −1 1 −1 −1 1 −1 1 −1 −1 1 −1 1 |
| | −1 1 1 −1 −1 −1 1 1 1 1 1 1 −1 −1 −1 −1 1 −1 1 −1 1 1 1 1 1 −1 1 1 −1 1 −1 1 −1 |
| | −1 −1 −1 −1 −1 −1 −1 −1 1 −1 −1 −1 1 −1 −1 −1 1 −1 −1 −1 1 1 −1 1 1 −1 1 −1 |
| | −1 1 −1 −1 1 1 −1 −1 1 1 1 −1 1 −1 −1 1 −1 1 −1 1 −1 1 −1 1 1 1 −1 −1 −1 −1 −1 |
| | −1 1 1 1 −1 1 1 −1 −1 −1 1 −1 1 −1 1 1 1 −1 1 −1 1 1 1 1 −1 1 −1 1 −1 −1 1 −1 −1 |
| | −1 1 1 1 1 1 1 −1 −1 1 −1 −1 −1 −1 1 −1 −1 −1 −1 1 1 1 1 −1 1 −1 −1 −1 −1 1 1 1 |
| | 1 1 −1 −1 1 −1 −1 −1 −1 −1 −1 1 −1 1 −1 −1 −1 −1 1 1 1 −1 −1 −1 1 1 −1 1 1 1 1 |
| | −1 1 1 −1 −1 −1 −1 1 −1 −1 −1 −1 1 1 −1 1 1 1 1 1 1 1 −1 −1 1 −1 1 −1 −1 1 −1 1 |
| | −1 −1 1 1 −1 1 −1 −1 −1 −1 −1 1 1 −1 −1 −1 1 −1 −1 −1 1 −1 −1 −1 −1 1 1 1 −1 1 |
| | −1 1 1 −1 −1 1 1 1 −1 −1 1 −1 1 −1 −1 1 1 −1 1 1 −1 1 −1 1 −1 −1 1 1 1 1 1 −1 −1 |
| | 1 −1 −1 1 −1 1 −1 −1 1 −1 1 1 1 −1 −1 1 1 −1 −1 −1 −1 1 −1 −1 −1 −1 −1 1 1 1 −1 |
| | −1 −1 −1 −1 −1 −1 1 1 −1 1 −1 −1 −1 −1 1 1 1 −1 −1 1 1 −1 −1 −1 −1 −1 −1 1 −1 |
| | 1 1 −1 −1 −1 1 −1 1 −1 −1 −1 −1 1 −1 −1 1 1 1 1 1 −1 1 1 −1 −1 1 1 1 −1 −1 1 1 1 |
| | 1 −1 −1 −1 1 −1 −1 1 1 1 1 −1 −1 1 1 −1 1 1 1 1 −1 1 1 1 −1 1 −1 −1 1 1 1 1 −1 1 |
| | 1 1 1 1 1 1 −1 1 −1 1 −1 1 −1 1 −1 1 −1 1 −1 −1 −1 1 −1 −1 1 1 −1 −1 1 −1 −1 −1 |
| | −1 −1 −1 −1 1 −1 1 1 −1 −1 1 1 1 1 1 1 1 1 −1 1 −1 −1 1 1 1 1 −1 −1 1 −1 1 −1 −1 |
| | −1 1 −1 1 1 1 1 −1 1 −1 1 1 1 −1 1 1 −1 1 1 1 1 −1 −1 1 −1 1 −1 −1 1 1 1 1 −1 −1 |
| | −1 1 −1 1 1 −1 1 −1 1 1 −1 −1 1 1 −1 1 1 −1 1 1 −1 −1 1 1 1 −1 −1 −1 1 −1 1 1 1 1 |
| | −1 1 1 1 −1 1 1 −1 −1 1 −1 −1 1 −1 −1 −1 1 −1 1 1 −1 1 −1 −1 −1 1 1 −1 1 −1 1 1 |
| | −1 −1 −1 1 −1 1 1 1 1 1 −1 −1 −1 1 1 1 −1 −1 1 1 1 −1 −1 −1 −1 1 1 −1 1 1 1 −1 |
| | −1 −1 −1 1 −1 1 −1 1 −1 1 −1 1 1 −1 −1 1 −1 1 1 1 −1 −1 −1 −1 −1 1 −1 −1 −1 1 1 |
| | 1 −1 −1 −1 −1 1 −1 −1 1 1 1 1 −1 −1 −1 1 1 1 −1 −1 −1 1 −1 −1 1 1 1 −1 −1 1 1 |
| | −1 1 −1 −1 −1 −1 −1 −1 1 1 −1 1 −1 1 1 1 −1 −1 1 −1 −1 1 1 1 1 1 −1 −1 −1 1 1 |
| | −1 1 1 −1 −1 1 −1 −1 −1 −1 −1 −1 1 1 1 1 −1 1 1 −1 −1 −1 1 −1 1 1 1 −1 1 1 −1 1 |
| | −1 −1 −1 1 1 1 −1 1 −1 −1 −1 −1 −1 1 −1 −1 −1 −1 1 1 −1 −1 1 −1 1 −1 −1 −1 1 1 |
| | −1 −1 −1 −1 −1 1 −1 1 1 −1 1 −1 1 −1 1 1 −1 −1 −1 1 1 −1 1 −1 1 1 1 1 1 −1 1 1 1 |
| | 1 1 1 1 1 1 1 1 1 −1 1 −1 1 −1 −1 −1 −1 −1 −1 1 −1 1 1 1 1 1 −1 1 1 −1 −1 −1 −1 |
| | −1 1 1 1 1 1 1 −1 1 1 −1 −1 −1 1 1 −1 −1 −1 1 1 1 −1 1 −1 1 1 −1 1 1 −1 1 1 1 −1 |
| | 1 −1 1 −1 −1 1 −1 1 1 −1 −1 −1 1 1 1 −1 −1 −1 1 1 −1 −1 1 −1 1 1 −1 −1 1 1 1 −1 |
| | −1 −1 −1 −1 −1 1 −1 −1 1 −1 −1 −1 −1 −1 1 −1 −1 1 −1 1 1 −1 1 1 −1 1 −1 1 −1 1 |
| | −1 −1 −1 −1 1 −1 −1 1 −1 1 −1 1 1 −1 −1 1 1 −1 1 −1 −1 −1 1 1 1 −1 −1 −1 1 −1 1 |
| | 1 −1 1 1 1 −1 −1 1 −1 −1 1 −1 −1 −1 −1 1 −1 −1 1 1 −1 −1 −1 1 −1 1 −1 −1 1 1 −1 |
| | 1 1 1 1 1 1 1 1 −1 −1 −1 −1 1 1 −1 1 −1 −1 1 1 1 −1 1 −1 1 −1 −1 1 −1 −1 1 1 −1 1 |
| | −1 −1 −1 1 1 −1 −1 1 −1 −1 1 −1 −1 1 −1 1 −1 −1 −1 1 −1 −1 −1 −1 −1 1 1 −1 1 1 |
| | 1 1 −1 −1 −1 1 1 1 −1 1 −1 −1 −1 1 −1 −1 −1 1 1 1 −1 −1 1 −1 −1 −1 1 −1 −1 −1 |
| | −1 1 −1 1 1 1 1 −1 −1 1 1 −1 1 −1 −1 −1 1 −1 1 1 −1 1 −1 1 −1 −1 1 1 −1 1 −1 −1 |
| | 1 −1 1 1 −1 1 1 1 −1 1 −1 1 1 −1 −1 −1 −1 −1 1 1 1 −1 1 −1 −1 −1 −1 1 1 1 −1 1 1 |
| | −1 −1 1 1 1 1 1 −1 −1 −1 1 −1 −1 −1 1 1 1 −1 1 1 1 −1 1 −1 1 1 1 1 1 1 1 1 1 1 −1 |
| | 1 1 1 1 −1 1 1 1 1 −1 1 1 −1 1 1 1 −1 1 −1 −1 −1 1 1 1 −1 −1 1 1 1 1 −1 1 −1 −1 |
| | −1 1 −1 −1 −1 −1 1 −1 −1 1 −1 1 1 1 −1 −1 1 −1 −1 1 −1 1 −1 1 1 1 1 −1 −1 1 1 |
| | −1 −1 −1 1 −1 −1 1 −1 −1 1 −1 −1 −1 −1 −1 1 1 −1 −1 −1 −1 −1 1 −1 −1 1 1 1 1 |
| | −1 1 −1 −1 1 −1 1 1 1 −1 1 −1 −1 1 1 −1 −1 1 −1 −1 1 1 1 1 1 1 −1 1 1 −1 1 −1 −1 |
| | 1 1 1 1 −1 −1 −1 −1 −1 −1 1 1 −1 1 −1 −1 1 −1 −1 1 −1 1 1 −1 −1 1 −1 1 −1 −1 −1 |
| | 1 −1 −1 1 −1 1 1 −1 1 −1 −1 −1 −1 −1 1 −1 1 1 1 −1 −1 −1 −1 1 −1 1 1 1 1 1 1 −1 |
| | −1 1 1 −1 −1 −1 1 1 −1 −1 −1 1 −1 1 1 1 1 −1 −1 1 −1 −1 −1 −1 1 1 −1 1 −1 −1 −1 |
| | −1 −1 1 −1 −1 1 −1 −1 1 1 1 −1 1 −1 1 −1 1 1 1 −1 −1 −1 1 −1 1 1 −1 −1 1 −1 −1 |
| | 1 −1 1 1 −1 1 −1 1 −1 1 −1 −1 1 −1 −1 −1 1 −1 1 −1 1 −1 1 1 −1 1 1 −1 1 1 −1 −1 |
| | −1 −1 −1 1 1 −1 1 −1 1 1 −1 −1 1 1 1 1 −1 −1 −1 −1 1 1 −1 −1 1 1 −1 −1 1 −1 1 |
| | −1 1 1 1 −1 −1 −1 1 1 1 −1 −1 1 −1 1 1 −1 1 1 −1 −1 1 −1 1 −1 −1 −1 −1 −1 1 1 1 |
| | −1 −1 1 −1 1 −1 1 −1 −1 1 −1 1 −1 1 −1 1 1 1 −1 1 1 1 1 1 1 1 1 −1 1 −1 1 1 −1 1 |
| | −1 1 1 −1 1 −1 −1 1 −1 1 −1 1 1 −1 1 −1 −1 1 −1 −1 −1 −1 1 1 −1 1 1 −1 1 −1 1 |
| | −1 1 1 −1 1 −1 −1 1 1 −1 1 −1 −1 −1 1 −1 −1 1 1 1 1 −1 1 1 −1 −1 −1 −1 −1 −1 1 |
| | −1 1 −1 −1 1 −1 −1 1 −1 1 1 1 −1 −1 −1 −1 1 1 1 −1 1 −1 −1 −1 1 1 −1 1 1 −1 −1 |
| | 1 1 −1 1 −1 1 1 −1 −1 −1 −1 −1 −1 1 −1 −1 −1 1 1 1 1 −1 1 −1 −1 1 1 −1 −1 −1 1 |
| | 1 −1 −1 1 1 1 1 −1 −1 −1 1 1 −1 −1 1 −1 −1 1 1 −1 −1 −1 −1 1 1 1 −1 1 −1 1 −1 |
| | −1 1 1 −1 −1 1 1 −1 1 1 1 −1 1 1 −1 1 −1 −1 1 1 −1 1 1 −1 1 1 1 1 −1 −1 −1 −1 −1 |
| | −1 1 −1 −1 −1 −1 1 −1 1 1 −1 1 1 −1 −1 −1 1 −1 1 1 −1 −1 −1 1 1 −1 1 1 1 −1 1 |
| | −1 −1 1 −1 −1 −1 1 −1 1 1 1 1 1 −1 1 −1 −1 1 −1 1 1 −1 −1 −1 −1 1 −1 −1 1 1 −1 |
| | −1 1 1 1 1 1 1 −1 −1 1 −1 1 −1 1 1 1 1 1 1 −1 −1 1 −1 −1 1 −1 −1 −1 1 1 1 −1 −1 |
| | −1 1 1 1 −1 −1 −1 −1 −1 1 1 −1 −1 1 1 −1 −1 −1 −1 −1 −1 −1 −1 −1 1 1 1 1 −1 1 |
| | −1 −1 1 −1 −1 1 −1 −1 −1 1 1 −1 −1 1 −1 −1 −1 −1 1 1 1 −1 1 1 1 −1 −1 1 −1 −1 |
| | −1 1 1 1 1 1 −1 −1 1 1 1 1 1 1 −1 1 −1 1 −1 1 1 1 1 1 1 −1 1 1 1 −1 −1 1 1 1 −1 −1 |
| | 1 1 −1 −1 1 1 1 1 −1 −1 1 1 −1 −1 1 −1 1 1 −1 −1 −1 1 −1 −1 1 1 1 1 1 −1 −1 1 1 |
| | −1 −1 −1 −1 1 1 −1 1 −1 1 −1 −1 −1 1 1 −1 1 −1 −1 −1 1 1 1 1 −1 1 1 1 −1 −1 1 |
| | −1 −1 1 1 −1 1 −1 −1 1 1 −1 −1 1 −1 1 1 −1 1 −1 −1 −1 1 −1 −1 −1 −1 −1 −1 1 1 1 |
| | −1 −1 −1 1 1 1 1 −1 1 −1 1 −1 −1 1 1 −1 1 1 −1 −1 −1 −1 −1 1 −1 −1 −1 −1 −1 −1 |
| | 1 1 −1 −1 1 −1 −1 −1 −1 −1 1 −1 −1 −1 −1 −1 1 1 −1 −1 1 −1 1 1 1 1 −1 −1 −1 −1 |
| | −1 −1 −1 −1 1 −1 1 −1 1 −1 −1 1 1 −1 −1 −1 −1 1 −1 −1 1 −1 1 1 −1 −1 1 1 1 1 −1 |
| | 1 −1 1 1 −1 1 1 −1 −1 1 −1 −1 −1 1 −1 1 1 −1 −1 −1 1 −1 −1 −1 1 −1 1 −1 1 1 −1 |
| | −1 1 −1 1 −1 1 1 −1 1 1 1 −1 1 1 −1 −1 1 1 −1 −1 −1 1 1 −1 1 −1 −1 −1 −1 −1 −1 |
| | −1 1 1 1 1 −1 −1 −1 1 1 1 1 −1 1 1 1 1 −1 −1 −1 1 −1 −1 1 −1 1 −1 −1 1 −1 −1 1 |
| | −1 −1 1 −1 −1 1 1 1 −1 −1 −1 −1 −1 −1 −1 −1 1 1 1 1 1 1 1 −1 −1 1 1 −1 1 1 −1 |
| | −1 1 −1 −1 1 −1 1 −1 −1 −1 −1 −1 1 −1 1 1 −1 −1 1 −1 1 −1 1 −1 −1 −1 1 −1 1 −1 |
| | −1 1 1 1 −1 −1 −1 −1 1 1 1 1 −1 1 1 1 1 1 −1 1 1 1 1 −1 1 −1 1 −1 −1 −1 −1 1 −1 |
| | −1 −1 −1 −1 −1 −1 −1 1 1 −1 −1 −1 −1 −1 −1 −1 1 1 −1 −1 −1 1 −1 1 −1 −1 −1 1 |
| | 1 1 −1 −1 −1 −1 −1 −1 1 1 −1 −1 −1 1 1 1 1 −1 1 −1 −1 −1 1 1 −1 1 −1 −1 1 1 −1 |
| | 1 −1 1 −1 −1 −1 1 −1 −1 −1 −1 1 1 −1 −1 −1 −1 −1 −1 1 1 −1 −1 1 1 −1 1 −1 1 −1 |
| | 1 1 1 1 −1 −1 1 −1 −1 1 −1 −1 1 1 −1 1 1 1 1 −1 −1 −1 −1 1 −1 −1 −1 1 1 1 −1 1 |
| | −1 1 1 1 1 −1 −1 −1 −1 −1 1 −1 1 1 1 −1 1 −1 1 1 1 −1 −1 −1 −1 −1 1 1 −1 1 1 −1 |
| | −1 1 1 1 1 1 1 −1 1 1 1 1 1 −1 −1 −1 −1 −1 1 1 −1 1 −1 −1 1 1 −1 −1 −1 −1 −1 1 1 |
| | −1 1 1 1 −1 −1 1 −1 −1 −1 −1 1 −1 1 −1 1 1 −1 −1 −1 1 −1 1 −1 1 −1 1 1 1 1 −1 |
| | −1 −1 −1 1 1 1 1 −1 −1 1 −1 1 −1 1 −1 −1 −1 −1 −1 −1 −1 1 −1 −1 −1 1 1 −1 1 1 1 |
| | 1 1 −1 −1 1 1 −1 −1 1 −1 −1 1 1 −1 1 −1 1 1 −1 −1 1 −1 1 −1 −1 1 1 1 −1 −1 1 −1 |
| | −1 1 −1 −1 1 −1 −1 −1 1 −1 −1 1 1 1 1 1 1 −1 −1 1 1 1 1 1 −1 −1 −1 −1 −1 1 −1 |
| | −1 −1 −1 1 −1 −1 1 1 1 −1 1 1 1 −1 1 1 −1 −1 −1 −1 1 1 1 1 1 −1 1 −1 1 1 1 −1 −1 |
| | −1 1 −1 −1 1 1 −1 −1 1 1 −1 1 −1 1 1 1 −1 1 −1 1 1 −1 1 1 1 1 −1 1 1 −1 1 −1 1 1 |
| | 1 1 1 1 −1 −1 −1 −1 1 1 1 1 1 −1 −1 −1 −1 1 −1 1 1 1 −1 1 −1 −1 1 −1 −1 1 1 1 1 |
| | −1 −1 −1 −1 1 −1 −1 1 1 −1 1 1 −1 1 −1 −1 −1 1 1 −1 −1 −1 −1 1 1 1 1 −1 1 −1 1 |
| | −1 1 1 −1 −1 −1 −1 1 1 1 1 −1 −1 −1 −1 −1 −1 −1 1 1 1 1 1 −1 1 1 −1 −1 −1 1 −1 |
| | −1 1 −1 −1 −1 −1 1 −1 1 1 −1 −1 1 1 −1 1 −1 1 −1 −1 1 −1 1 1 1 −1 1 1 −1 −1 1 1 |
| | 1 −1 1 1 −1 1 −1 1 1 1 −1 1 −1 −1 1 1 1 −1 −1 −1 1 −1 −1 −1 −1 −1 1 1 1 1 −1 1 |
| | −1 1 1 1 −1 −1 1 1 1 −1 −1 −1 1 1 −1 −1 −1 −1 −1 1 1 1 −1 −1 −1 1 −1 1 −1 −1 −1 |
| | 1 −1 1 1 −1 1 1 1 1 −1 −1 −1 1 −1 1 1 1 1 1 1 −1 1 1 −1 −1 1 1 −1 −1 1 1 −1 −1 −1 |
| | 1 1 1 1 1 −1 1 1 1 1 1 −1 1 −1 1 −1 −1 −1 1 −1 1 1 1 −1 −1 −1 −1 −1 −1 −1 1 −1 |
| | −1 −1 −1 1 1 1 −1 −1 −1 −1 1 1 1 −1 −1 −1 1 −1 −1 −1 1 −1 −1 1 −1 −1 1 −1 1 −1 |
| | 1 −1 −1 −1 1 1 1 1 −1 −1 −1 −1 1 1 1 −1 −1 1 1 1 −1 1 −1 1 1 −1 1 −1 −1 −1 1 −1 |
| | 1 −1 1 −1 1 −1 −1 −1 1 1 −1 −1 1 1 1 −1 1 1 1 −1 1 −1 −1 1 −1 1 −1 −1 −1 −1 −1 |
| | −1 −1 −1 1 1 1 −1 1 −1 1 1 1 −1 −1 1 −1 1 1 −1 1 −1 −1 1 1 1 −1 1 1 1 1 −1 −1 1 1 |
| | −1 −1 1 1 1 −1 −1 1 1 −1 1 1 −1 1 −1 1 1 −1 −1 1 −1 −1 −1 1 1 −1 −1 1 1 −1 1 −1 |
| | −1 −1 −1 1 −1 −1 1 1 −1 1 −1 −1 −1 −1 1 1 −1 −1 1 1 −1 1 1 1 1 1 −1 −1 −1 1 1 |
| | −1 −1 1 1 −1 −1 1 1 1 1 1 −1 −1 1 1 1 −1 1 −1 −1 −1 1 −1 1 −1 −1 1 −1 1 1 −1 1 1 |
| | −1 −1 −1 −1 −1 −1 1 1 1 1 −1 −1 1 1 −1 1 −1 1 −1 −1 −1 −1 −1 1 −1 1 −1 −1 1 1 1 |
| | −1 1 −1 1 1 −1 −1 −1 1 −1 −1 1 −1 1 −1 1 1 1 −1 −1 1 1 −1 1 1 1 −1 1 −1 −1 −1 |
| | −1 1 −1 −1 1 −1 −1 −1 −1 1 1 1 −1 −1 1 −1 −1 1 −1 1 1 1 −1 1 −1 1 1 −1 −1 1 −1 |
| | 1 1 −1 −1 1 −1 1 1 −1 1 1 1 1 −1 1 −1 −1 −1 −1 −1 −1 −1 −1 −1 −1 −1 1 −1 −1 1 1 |
| | 1 −1 1 −1 1 1 1 −1 1 1 1 1 −1 1 −1 1 1 −1 1 −1 −1 1 1 1 1 1 −1 1 −1 1 1 −1 −1 1 |
| | −1 −1 1 1 −1 −1 1 −1 −1 1 −1 1 −1 1 −1 1 −1 −1 1 −1 −1 1 1 1 1 1 −1 1 −1 −1 1 1 |
| | −1 −1 1 1 −1 −1 1 −1 −1 −1 −1 1 −1 1 1 1 −1 −1 1 1 −1 1 −1 1 1 1 1 1 1 1 −1 1 −1 |
| | −1 −1 −1 −1 −1 1 −1 1 −1 1 −1 1 1 −1 −1 1 1 1 −1 1 1 1 1 1 1 −1 −1 1 −1 1 1 1 −1 |
| | 1 −1 −1 −1 1 1 −1 −1 1 1 −1 −1 −1 1 −1 1 −1 1 1 −1 −1 −1 −1 −1 −1 −1 −1 1 −1 |
| | −1 −1 −1 −1 1 −1 −1 1 1 1 −1 −1 −1 −1 1 −1 1 −1 −1 −1 −1 −1 −1 −1 1 1 −1 1 1 |
| | −1 1 −1 −1 −1 −1 1 1 −1 1 1 −1 −1 −1 −1 −1 −1 −1 1 −1 1 1 1 −1 −1 1 −1 −1 −1 |
| | −1 −1 −1 −1 −1 −1 −1 1 1 1 −1 −1 −1 −1 1 −1 1 1 −1 1 −1 1 1 1 −1 −1 1 1 −1 −1 1 |
| | −1 −1 −1 1 1 1 1 −1 −1 1 1 −1 −1 −1 −1 −1 1 1 1 1 −1 1 1 1 −1 1 1 1 −1 −1 −1 1 |
| | −1 1 1 1 −1 −1 −1 1 −1 1 −1 −1 1 1 1 1 −1 1 −1 −1 −1 −1 −1 1 −1 1 −1 1 1 −1 1 1 |
| | −1 1 −1 −1 1 −1 1 1 −1 −1 1 −1 −1 −1 1 −1 −1 1 1 −1 1 −1 1 1 1 −1 −1 −1 −1 1 1 |
| | −1 −1 −1 −1 1 1 −1 −1 1 −1 1 1 −1 1 1 −1 1 1 1 1 1 1 1 1 1 −1 1 −1 −1 −1 1 −1 1 1 |
| | 1 −1 1 −1 1 −1 1 1 −1 1 1 1 −1 −1 1 1 −1 −1 −1 1 1 1 −1 1 1 1 −1 −1 −1 −1 1 −1 |
| | −1 −1 −1 −1 −1 1 −1 −1 1 1 1 1 1 1 1 −1 −1 1 −1 −1 −1 1 1 1 −1 1 1 −1 −1 −1 −1 |
| | −1 −1 −1 −1 −1 −1 1 −1 1 1 −1 1 1 −1 1 −1 −1 −1 −1 −1 1 1 1 −1 1 1 1 1 1 −1 1 1 |
| | −1 1 1 1 1 −1 1 1 1 1 1 1 −1 −1 −1 −1 −1 1 −1 1 −1 1 1 1 1 −1 −1 −1 1 1 −1 1 −1 1 |
| | 1 −1 1 −1 −1 −1 −1 −1 −1 −1 −1 1 −1 1 1 1 1 −1 −1 −1 1 1 1 1 1 1 −1 1 −1 1 1 1 |
| | −1 1 −1 −1 −1 1 −1 −1 1 1 −1 1 1 1 −1 1 1 1 1 1 −1 −1 −1 1 −1 −1 1 1 −1 1 1 −1 |
| | −1 −1 1 −1 −1 −1 1 1 1 1 1 −1 1 1 −1 1 −1 −1 −1 1 −1 1 1 1 1 1 1 1 1 −1 −1 1 −1 |
| | −1 1 1 −1 1 1 −1 −1 1 1 1 −1 1 −1 −1 −1 −1 −1 −1 −1 1 −1 1 −1 −1 1 1 −1 −1 −1 |
| | −1 −1 −1 1 1 1 −1 −1 1 1 −1 1 −1 1 −1 1 −1 1 −1 −1 1 −1 1 1 −1 1 −1 −1 1 −1 1 1 |
| | 1 −1 −1 −1 1 1 −1 1 1 −1 1 1 1 −1 1 1 1 1 −1 −1 1 −1 −1 1 1 −1 −1 1 1 −1 −1 −1 |
| | −1 1 −1 1 −1 1 −1 −1 −1 −1 1 1 1 −1 1 −1 −1 1 1 −1 −1 −1 −1 1 1 −1 −1 −1 −1 −1 |
| | 1 1 −1 −1 1 −1 −1 1 −1 1 1 1 1 1 1 1 −1 1 1 −1 1 −1 1 1 −1 1 −1 1 1 1 1 1 −1 −1 1 |
| | −1 1 −1 −1 −1 −1 −1 −1 1 1 −1 −1 1 −1 1 −1 1 −1 −1 1 1 −1 1 −1 1 1 1 1 −1 1 −1 −1 |
| | −1 1 1 1 1 1 −1 −1 −1 1 −1 1 −1 −1 1 −1 1 −1 −1 −1 1 1 1 1 1 1 1 1 −1 1 1 −1 −1 1 |
| | −1 −1 1 1 −1 1 1 1 −1 −1 1 −1 1 −1 1 1 1 −1 1 −1 −1 1 −1 1 1 −1 1 −1 1 1 1 1 −1 |
| | −1 1 1 1 −1 1 1 1 1 −1 1 1 −1 −1 1 −1 −1 −1 1 1 1 −1 −1 1 1 −1 1 1 1 1 1 1 −1 1 1 |
| | −1 1 1 −1 −1 1 −1 −1 1 1 1 1 −1 1 1 1 −1 1 −1 1 1 −1 1 −1 1 −1 −1 −1 −1 1 −1 1 |
| | −1 1 −1 1 1 1 −1 −1 1 −1 1 −1 −1 −1 −1 1 −1 −1 −1 1 −1 1 −1 1 −1 −1 1 1 1 −1 1 |
| | −1 −1 1 1 −1 1 1 1 −1 1 1 1 1 1 1 −1 −1 −1 1 −1 −1 −1 −1 1 −1 −1 −1 −1 −1 1 |
| | −1 1 1 −1 1 1 1 1 1 −1 1 1 1 −1 −1 −1 −1 −1 1 1 1 1 −1 −1 1 −1 −1 −1 −1 −1 1 1 1 |
| | 1 1 1 1 1 −1 −1 1 1 −1 −1 1 1 −1 −1 1 1 −1 1 −1 −1 1 −1 −1 −1 1 −1 −1 1 −1 1 −1 |
| | 1 −1 1 1 −1 −1 −1 1 −1 −1 −1 −1 −1 −1 −1 −1 −1 1 1 −1 1 1 1 1 1 −1 1 1 −1 −1 1 |
| | −1 1 1 −1 −1 −1 −1 −1 1 1 −1 −1 −1 −1 1 1 1 −1 −1 −1 −1 −1 1 −1 −1 1 1 −1 1 1 1 |
| | 1 1 −1 1 −1 −1 1 1 1 −1 −1 1 1 1 −1 1 1 1 −1 −1 −1 1 1 1 −1 1 1 1 1 −1 1 −1 −1 1 |
| | 1 1 1 1 −1 −1 −1 −1 1 1 1 −1 1 1 −1 1 1 −1 1 −1 −1 1 1 1 −1 −1 1 −1 1 1 1 −1 −1 1 |
| | 1 1 −1 1 −1 −1 1 1 1 1 1 1 −1 1 −1 −1 −1 −1 1 −1 −1 −1 −1 1 −1 1 −1 −1 −1 1 1 1 |
| | 1 −1 1 −1 1 1 −1 −1 1 1 −1 −1 1 1 1 −1 1 1 −1 −1 −1 −1 1 −1 1 −1 1 1 −1 1 −1 −1 |
| | −1 −1 1 −1 1 −1 −1 1 −1 −1 −1 −1 −1 1 −1 1 1 1 1 −1 1 −1 −1 1 −1 −1 −1 −1 1 −1 |
| | −1 −1 1 1 −1 1 −1 1 −1 1 1 1 −1 −1 1 1 1 1 −1 1 1 −1 1 1 1 1 1 1 −1 1 −1 −1 −1 1 |
| | 1 1 −1 1 1 −1 1 −1 1 −1 1 1 1 1 1 −1 −1 −1 1 −1 1 1 −1 −1 −1 −1 1 1 1 −1 −1 1 −1 |
| | 1 1 1 1 −1 −1 1 −1 1 −1 1 1 −1 1 −1 1 1 1 −1 1 1 −1 −1 1 −1 1 1 1 −1 1 −1 1 −1 −1 |
| | 1 1 1 −1 −1 1 1 −1 −1 −1 1 −1 1 1 1 −1 −1 1 1 1 1 1 1 |
| 2 | −1 −1 −1 −1 −1 −1 −1 −1 −1 −1 −1 −1 −1 1 −1 1 1 1 −1 1 1 1 −1 −1 1 1 −1 1 −1 1 |
| | 1 1 −1 1 −1 −1 1 1 1 −1 −1 1 1 −1 −1 −1 1 1 −1 −1 1 1 1 1 −1 −1 −1 1 −1 1 1 −1 1 |
| | 1 1 −1 −1 1 1 1 1 1 1 −1 −1 −1 1 1 1 −1 1 −1 −1 −1 −1 −1 −1 1 1 1 −1 −1 −1 −1 |
| | −1 −1 −1 −1 1 −1 −1 1 −1 −1 −1 −1 1 −1 1 −1 −1 −1 −1 −1 1 −1 −1 −1 −1 1 −1 −1 |
| | 1 1 1 1 −1 −1 −1 1 −1 −1 −1 1 1 1 −1 1 −1 1 −1 1 −1 1 −1 1 1 1 1 1 −1 1 −1 −1 1 |
| | −1 −1 1 −1 −1 1 −1 −1 −1 1 −1 1 −1 1 −1 1 −1 1 1 −1 1 1 1 1 1 −1 −1 −1 1 −1 1 1 |
| | −1 −1 −1 −1 −1 −1 −1 −1 1 1 −1 1 1 −1 1 −1 −1 −1 −1 1 1 1 1 −1 1 −1 1 −1 1 1 −1 |
| | 1 −1 −1 1 −1 1 1 1 −1 1 −1 1 −1 −1 −1 1 −1 −1 1 1 −1 −1 −1 −1 1 −1 −1 1 −1 −1 |
| | −1 1 1 −1 −1 −1 1 −1 1 −1 −1 1 1 1 1 1 −1 −1 −1 1 −1 1 −1 1 1 −1 −1 1 1 −1 −1 |
| | −1 1 1 1 −1 1 −1 1 −1 −1 1 −1 −1 1 −1 −1 1 1 1 1 1 −1 −1 1 1 −1 −1 −1 −1 1 1 −1 |
| | −1 −1 1 1 1 1 1 1 1 1 1 1 −1 1 −1 1 −1 −1 1 1 −1 −1 −1 1 −1 1 1 −1 −1 1 −1 −1 1 |
| | −1 1 1 −1 −1 −1 −1 1 −1 1 −1 −1 −1 −1 1 −1 1 −1 −1 1 −1 −1 −1 −1 1 −1 1 1 1 1 |
| | −1 −1 −1 1 −1 −1 1 1 1 −1 −1 −1 −1 −1 −1 −1 1 −1 1 −1 1 1 1 −1 −1 −1 −1 −1 −1 |
| | 1 1 1 1 1 −1 1 1 1 1 1 −1 1 −1 1 −1 −1 1 −1 1 1 −1 1 1 −1 1 −1 1 1 1 −1 −1 1 −1 |
| | −1 −1 −1 1 1 −1 −1 −1 −1 −1 1 −1 −1 −1 −1 −1 −1 −1 −1 1 −1 1 1 −1 1 −1 1 1 1 1 |
| | 1 1 1 1 1 1 −1 −1 1 −1 −1 −1 −1 −1 −1 −1 1 1 1 1 −1 1 1 −1 −1 −1 −1 1 −1 1 1 −1 |
| | −1 1 1 1 1 1 −1 −1 1 1 1 1 1 −1 1 −1 1 −1 −1 −1 1 −1 1 −1 −1 −1 −1 1 1 1 −1 1 1 1 |
| | −1 1 −1 −1 1 −1 −1 −1 1 −1 −1 1 1 1 −1 1 −1 −1 1 −1 1 1 1 1 1 −1 −1 −1 1 −1 −1 |
| | −1 1 −1 −1 1 1 −1 −1 1 1 −1 −1 −1 −1 1 −1 −1 −1 1 1 −1 1 −1 1 −1 −1 −1 −1 −1 |
| | −1 1 −1 −1 −1 1 1 1 1 1 1 1 1 −1 −1 1 1 −1 −1 1 −1 1 −1 −1 1 −1 −1 1 −1 −1 −1 |
| | −1 −1 1 1 1 1 1 1 1 −1 1 −1 −1 −1 1 1 −1 1 −1 −1 −1 1 −1 1 1 −1 1 1 1 1 1 −1 1 1 |
| | −1 −1 1 −1 1 −1 −1 1 −1 1 −1 1 −1 −1 1 1 1 1 −1 1 −1 1 −1 1 −1 1 −1 −1 −1 −1 1 |
| | 1 1 −1 −1 −1 −1 −1 1 1 1 1 −1 1 −1 −1 −1 1 −1 −1 −1 −1 1 1 1 −1 −1 −1 1 1 −1 1 |
| | 1 −1 1 1 −1 1 −1 −1 −1 1 1 1 −1 1 1 1 1 1 1 −1 −1 1 −1 −1 −1 1 1 1 −1 1 −1 −1 1 |
| | −1 −1 1 1 −1 1 1 −1 1 1 1 1 1 −1 1 −1 1 1 1 −1 −1 1 −1 1 1 1 1 1 1 1 −1 −1 1 1 1 |
| | −1 1 1 1 1 −1 −1 −1 1 −1 1 1 1 −1 −1 1 −1 1 −1 1 1 −1 1 −1 −1 1 1 −1 −1 1 −1 −1 |
| | 1 1 −1 1 −1 −1 −1 1 −1 −1 1 −1 −1 1 −1 1 −1 −1 −1 −1 1 1 −1 −1 1 −1 1 1 1 1 −1 |
| | −1 1 1 1 −1 −1 −1 1 −1 1 1 1 −1 1 −1 1 1 −1 −1 −1 −1 1 1 −1 −1 1 1 1 −1 1 −1 1 |
| | −1 1 −1 −1 1 −1 1 1 −1 −1 −1 1 1 −1 −1 −1 1 −1 1 1 1 −1 1 1 −1 −1 −1 −1 1 1 1 1 |
| | 1 −1 −1 1 −1 1 −1 1 1 −1 −1 1 1 1 1 1 1 1 −1 1 1 −1 −1 −1 1 1 1 1 −1 1 −1 1 −1 −1 |
| | −1 1 1 −1 1 −1 −1 1 −1 1 1 1 1 −1 1 1 −1 1 1 1 −1 1 1 −1 −1 1 1 1 −1 −1 −1 −1 1 1 |
| | −1 −1 1 −1 1 −1 −1 −1 −1 −1 −1 −1 1 −1 1 −1 −1 −1 −1 −1 −1 1 1 −1 −1 −1 1 −1 |
| | 1 −1 1 −1 −1 1 1 −1 1 −1 −1 −1 −1 −1 −1 −1 −1 1 1 1 1 1 1 1 1 −1 1 −1 −1 −1 −1 |
| | −1 1 1 −1 1 1 1 −1 −1 1 1 1 −1 −1 −1 −1 −1 1 −1 1 1 1 1 1 −1 1 1 1 1 1 1 −1 1 1 |
| | −1 1 −1 −1 1 −1 −1 −1 1 1 −1 1 −1 1 1 1 1 −1 −1 1 −1 −1 −1 1 1 −1 1 −1 −1 −1 −1 |
| | 1 −1 1 −1 −1 −1 1 1 −1 −1 −1 1 1 1 −1 1 1 −1 1 −1 1 1 1 1 −1 1 1 −1 1 −1 −1 1 1 1 |
| | 1 1 1 1 −1 −1 1 −1 1 −1 −1 1 −1 1 1 −1 1 −1 1 −1 −1 1 −1 −1 −1 −1 −1 −1 1 −1 1 |
| | −1 −1 1 −1 −1 1 1 −1 −1 1 −1 −1 1 −1 1 −1 −1 −1 1 −1 −1 −1 −1 −1 1 1 1 −1 1 1 |
| | −1 −1 −1 −1 1 −1 −1 −1 1 −1 1 −1 −1 1 1 1 −1 −1 1 −1 −1 −1 1 1 −1 −1 1 1 −1 −1 |
| | −1 1 1 −1 1 −1 −1 1 1 1 1 −1 1 1 1 −1 −1 −1 −1 −1 1 −1 1 −1 −1 −1 1 −1 −1 −1 1 |
| | 1 −1 1 1 1 −1 1 −1 1 −1 1 1 1 1 1 −1 −1 1 1 1 −1 1 −1 −1 −1 −1 −1 1 −1 −1 1 −1 1 |
| | 1 −1 −1 1 −1 1 1 1 1 −1 1 −1 −1 1 −1 1 1 1 −1 −1 1 −1 −1 −1 1 −1 −1 −1 −1 1 1 |
| | −1 1 1 −1 1 −1 1 1 1 1 1 −1 −1 −1 1 1 1 1 1 −1 1 −1 1 −1 1 1 −1 −1 1 1 1 −1 −1 −1 |
| | 1 −1 −1 −1 −1 −1 1 1 −1 1 −1 1 −1 1 1 −1 1 1 −1 1 1 1 −1 1 1 1 1 −1 1 1 1 1 −1 −1 |
| | −1 1 1 −1 −1 1 −1 1 −1 −1 1 1 1 −1 −1 −1 1 1 −1 1 −1 1 −1 1 −1 −1 1 −1 −1 −1 1 |
| | −1 −1 −1 −1 −1 −1 1 1 1 1 −1 −1 1 −1 1 −1 1 1 1 1 −1 1 1 −1 −1 1 1 1 1 −1 −1 1 1 |
| | −1 −1 1 1 1 −1 1 1 1 −1 −1 −1 1 1 1 1 −1 1 1 1 −1 1 −1 −1 1 1 1 1 1 −1 1 −1 1 1 1 |
| | 1 1 −1 −1 1 −1 −1 1 1 −1 1 1 −1 −1 −1 −1 1 1 1 −1 −1 1 −1 1 1 −1 −1 1 −1 −1 1 1 |
| | −1 −1 −1 −1 1 1 1 −1 −1 −1 1 −1 1 −1 1 −1 −1 −1 −1 1 1 −1 1 1 −1 −1 1 −1 1 1 −1 |
| | −1 −1 −1 1 1 −1 1 −1 −1 1 −1 −1 1 1 −1 −1 −1 1 1 1 −1 −1 1 −1 −1 −1 −1 1 −1 1 1 |
| | −1 −1 1 −1 −1 −1 1 −1 1 −1 1 1 −1 1 1 1 1 −1 1 1 −1 1 1 −1 1 −1 1 −1 1 −1 1 1 1 |
| | −1 1 −1 −1 −1 1 1 1 −1 −1 1 1 −1 1 −1 −1 1 1 1 1 1 −1 −1 1 −1 1 1 −1 −1 −1 −1 |
| | −1 −1 1 1 −1 1 −1 −1 −1 −1 1 1 −1 1 −1 −1 −1 −1 −1 −1 1 1 −1 1 1 −1 −1 1 1 −1 |
| | −1 −1 −1 1 1 1 1 1 1 1 −1 −1 1 1 −1 1 −1 1 1 −1 1 −1 −1 −1 −1 −1 1 −1 1 1 −1 −1 |
| | 1 1 −1 −1 −1 −1 −1 −1 −1 1 1 −1 −1 −1 −1 −1 1 1 1 1 −1 −1 1 1 −1 1 1 1 −1 −1 −1 |
| | 1 −1 −1 1 1 −1 −1 −1 1 −1 1 −1 1 1 1 −1 1 −1 −1 1 −1 −1 1 −1 1 −1 1 −1 −1 −1 1 |
| | 1 −1 −1 −1 −1 −1 −1 −1 1 −1 1 1 −1 −1 1 −1 1 1 −1 −1 1 1 −1 1 −1 −1 1 −1 1 1 −1 |
| | −1 1 1 1 1 −1 1 1 1 1 −1 −1 1 −1 −1 −1 −1 −1 1 1 −1 1 1 −1 1 1 1 1 −1 1 −1 −1 1 |
| | −1 −1 −1 −1 −1 −1 −1 1 −1 −1 −1 −1 1 −1 1 −1 −1 1 1 1 1 −1 1 1 −1 1 1 −1 −1 1 |
| | −1 −1 1 1 −1 1 1 1 1 1 −1 1 −1 −1 −1 −1 −1 −1 −1 1 1 1 −1 1 −1 1 −1 1 1 −1 1 1 1 |
| | −1 −1 1 −1 −1 −1 1 1 1 1 −1 1 −1 1 1 1 1 1 1 1 −1 −1 −1 −1 −1 −1 1 −1 −1 1 −1 1 |
| | −1 −1 −1 −1 −1 −1 1 −1 1 1 −1 1 1 −1 −1 1 1 −1 −1 1 1 −1 1 1 −1 −1 1 1 1 −1 −1 |
| | 1 1 −1 1 −1 1 −1 −1 1 1 −1 1 −1 1 1 1 −1 −1 1 1 1 1 −1 1 −1 1 −1 −1 1 −1 −1 −1 1 |
| | 1 1 1 −1 −1 1 −1 1 1 −1 −1 1 1 1 −1 1 −1 1 1 −1 1 −1 1 1 −1 1 −1 1 −1 −1 1 1 1 1 |
| | −1 −1 1 −1 −1 1 1 −1 −1 −1 1 −1 −1 1 −1 1 1 1 −1 −1 −1 −1 −1 1 1 1 −1 1 −1 −1 |
| | −1 1 −1 −1 −1 1 −1 −1 1 −1 1 1 1 1 1 1 −1 −1 −1 −1 1 −1 −1 −1 1 −1 −1 1 1 1 1 |
| | −1 1 −1 1 1 −1 1 1 −1 1 1 −1 1 −1 1 1 −1 1 1 1 −1 1 1 −1 1 −1 −1 1 −1 1 1 −1 1 −1 |
| | −1 1 1 1 −1 1 1 −1 −1 1 1 1 1 1 1 −1 1 −1 1 −1 1 1 1 1 −1 1 1 1 1 −1 1 1 −1 1 −1 1 |
| | −1 −1 1 1 −1 −1 1 −1 1 1 1 1 1 1 −1 1 1 1 1 −1 1 1 1 −1 1 1 −1 1 −1 1 −1 1 1 1 1 |
| | −1 −1 −1 −1 1 −1 −1 −1 −1 1 1 1 1 −1 −1 −1 1 1 1 −1 −1 −1 −1 1 −1 1 −1 −1 1 −1 |
| | 1 1 1 1 −1 −1 −1 1 1 1 −1 1 1 1 1 −1 −1 1 −1 1 1 1 −1 1 −1 1 1 1 1 1 −1 1 −1 1 −1 |
| | 1 −1 1 1 1 1 −1 1 −1 −1 −1 −1 1 −1 1 1 −1 −1 −1 1 1 −1 1 1 −1 −1 1 −1 −1 −1 1 |
| | −1 −1 1 −1 1 −1 −1 −1 1 1 1 1 −1 −1 −1 −1 1 −1 −1 1 1 −1 1 1 −1 1 −1 −1 −1 1 −1 |
| | −1 1 1 1 −1 −1 1 1 1 −1 −1 −1 1 1 −1 −1 1 −1 −1 1 1 1 1 −1 1 −1 −1 −1 1 1 1 1 −1 |
| | 1 −1 −1 −1 −1 1 1 −1 −1 −1 −1 1 −1 1 −1 −1 1 1 −1 −1 1 1 1 1 −1 1 −1 1 1 1 −1 |
| | −1 −1 1 −1 1 1 −1 −1 1 1 1 −1 −1 1 −1 1 −1 −1 1 1 1 1 1 1 1 1 1 −1 −1 1 1 1 1 −1 |
| | −1 1 1 1 1 −1 1 1 1 −1 1 1 1 −1 1 1 −1 −1 −1 1 1 1 −1 1 −1 −1 1 1 1 −1 1 −1 −1 −1 |
| | −1 1 −1 1 −1 1 1 −1 1 −1 1 1 1 1 −1 −1 −1 1 1 −1 1 −1 1 1 −1 1 −1 1 1 1 −1 1 1 −1 |
| | 1 −1 1 1 −1 −1 1 1 1 1 −1 −1 −1 −1 1 −1 1 −1 −1 −1 1 −1 1 1 −1 1 −1 −1 −1 1 −1 |
| | −1 −1 −1 −1 −1 −1 −1 −1 1 −1 1 −1 −1 1 1 1 −1 1 −1 1 −1 −1 −1 −1 −1 −1 −1 1 1 |
| | −1 1 −1 −1 1 1 −1 1 −1 −1 1 −1 −1 1 −1 1 1 −1 1 −1 −1 −1 −1 −1 −1 1 −1 1 −1 1 |
| | −1 1 −1 1 −1 1 −1 1 1 −1 −1 −1 −1 1 1 1 1 −1 1 1 1 −1 −1 1 1 1 1 −1 −1 1 −1 −1 |
| | −1 −1 1 −1 −1 −1 1 −1 1 1 1 −1 1 1 1 1 1 −1 1 −1 −1 1 1 1 −1 −1 −1 −1 1 −1 −1 |
| | −1 −1 −1 −1 −1 1 −1 1 1 1 1 −1 −1 1 −1 1 −1 1 −1 −1 −1 −1 1 −1 1 −1 1 −1 1 −1 |
| | −1 1 −1 −1 1 −1 1 −1 −1 1 1 −1 1 −1 1 −1 −1 1 −1 1 −1 −1 1 −1 −1 −1 −1 −1 1 −1 |
| | 1 1 −1 1 −1 −1 −1 −1 1 1 −1 −1 1 1 −1 −1 1 1 1 1 1 1 −1 −1 1 −1 −1 1 −1 −1 1 −1 |
| | −1 1 −1 1 1 −1 −1 1 1 −1 −1 1 1 1 −1 −1 −1 −1 −1 −1 1 −1 1 1 −1 −1 −1 1 −1 1 −1 |
| | 1 −1 1 −1 −1 −1 1 1 1 −1 −1 1 −1 1 −1 −1 −1 −1 −1 1 1 −1 −1 1 1 1 −1 −1 1 −1 −1 |
| | 1 1 1 1 −1 −1 1 1 −1 1 −1 −1 1 −1 −1 −1 1 −1 1 −1 −1 1 −1 −1 1 −1 1 1 1 −1 1 −1 |
| | −1 1 1 −1 1 1 1 1 1 1 −1 1 −1 −1 1 1 −1 −1 −1 1 −1 −1 −1 1 −1 1 1 1 1 −1 −1 1 1 |
| | −1 1 1 −1 1 1 −1 1 1 1 1 1 1 −1 1 1 1 −1 1 −1 1 1 1 −1 1 −1 −1 −1 −1 −1 −1 −1 −1 |
| | −1 −1 −1 1 1 −1 −1 1 −1 −1 −1 1 −1 1 1 −1 −1 −1 1 −1 −1 1 −1 −1 1 1 1 −1 1 −1 1 |
| | 1 −1 −1 1 −1 1 −1 −1 1 1 −1 1 1 −1 1 −1 1 1 −1 −1 −1 −1 −1 1 −1 1 1 −1 1 1 1 1 |
| | −1 1 −1 1 −1 1 −1 −1 1 1 −1 −1 −1 −1 1 −1 1 −1 1 −1 −1 −1 −1 −1 −1 1 1 1 1 1 1 |
| | −1 −1 1 1 −1 1 1 −1 −1 −1 1 1 1 −1 −1 1 1 1 1 −1 1 1 −1 1 −1 1 1 1 −1 1 −1 1 −1 |
| | −1 1 −1 1 −1 1 −1 1 −1 −1 1 1 1 −1 −1 1 1 1 1 1 1 1 1 1 1 1 −1 1 1 −1 1 −1 1 −1 1 |
| | −1 −1 −1 −1 −1 1 1 1 −1 1 −1 1 1 −1 −1 −1 1 −1 −1 −1 −1 −1 −1 1 −1 −1 −1 −1 |
| | −1 −1 1 1 −1 −1 1 −1 1 1 −1 −1 1 −1 1 −1 −1 −1 −1 1 1 1 1 −1 −1 1 −1 −1 1 −1 1 |
| | 1 −1 1 1 1 1 −1 −1 1 −1 −1 1 1 1 1 1 1 −1 1 −1 −1 1 −1 1 1 −1 1 1 1 −1 1 1 1 −1 1 |
| | −1 1 1 −1 1 −1 −1 −1 1 1 −1 −1 1 −1 1 −1 1 −1 −1 1 −1 1 1 1 1 1 1 1 1 1 −1 1 1 1 |
| | −1 1 1 −1 −1 1 −1 −1 1 −1 −1 1 −1 1 −1 1 1 1 1 1 1 1 1 −1 −1 1 −1 1 1 1 −1 −1 1 |
| | −1 1 1 −1 −1 −1 1 1 1 1 1 1 −1 −1 −1 1 −1 −1 1 1 −1 1 1 −1 −1 1 1 −1 1 1 1 1 1 −1 |
| | −1 1 1 −1 −1 1 1 −1 1 −1 1 1 1 1 −1 1 −1 1 −1 −1 −1 −1 −1 1 1 −1 1 −1 −1 1 −1 1 |
| | −1 −1 −1 −1 1 −1 1 1 1 −1 −1 −1 1 1 1 −1 −1 1 −1 1 1 1 1 −1 −1 −1 −1 −1 −1 −1 1 |
| | −1 −1 1 −1 1 1 1 1 −1 −1 1 −1 −1 1 −1 −1 −1 1 1 1 −1 −1 −1 −1 −1 −1 1 1 −1 −1 |
| | −1 −1 1 −1 −1 1 1 1 1 1 1 1 1 −1 1 1 1 1 −1 −1 −1 −1 −1 1 −1 1 1 −1 −1 −1 −1 1 |
| | −1 −1 1 1 −1 −1 −1 1 1 −1 1 1 1 −1 1 1 −1 1 1 1 −1 −1 1 −1 1 1 −1 1 1 −1 1 1 −1 |
| | −1 1 −1 1 −1 −1 −1 1 −1 −1 1 1 1 1 1 −1 1 1 1 1 −1 1 −1 −1 1 1 1 1 −1 −1 1 1 1 −1 |
| | 1 −1 1 1 1 −1 1 1 1 1 −1 −1 1 1 −1 −1 1 −1 −1 1 1 1 −1 1 −1 −1 −1 1 −1 1 1 −1 −1 |
| | −1 −1 1 1 1 −1 1 −1 1 1 1 1 1 1 −1 1 1 −1 −1 1 1 1 −1 1 1 1 1 1 1 1 1 −1 −1 −1 1 |
| | −1 1 1 1 1 1 −1 −1 1 1 −1 1 −1 −1 −1 1 1 −1 1 1 −1 −1 −1 −1 −1 1 1 1 −1 −1 −1 |
| | −1 1 1 1 −1 1 1 1 1 −1 1 −1 1 1 1 −1 1 1 −1 −1 1 −1 1 −1 1 −1 1 1 −1 −1 1 −1 1 −1 |
| | 1 −1 −1 −1 1 −1 1 1 −1 −1 1 1 −1 1 1 1 −1 −1 1 −1 1 −1 1 −1 1 −1 −1 −1 −1 −1 −1 |
| | −1 −1 −1 1 1 −1 1 −1 1 −1 −1 −1 1 1 1 1 −1 1 1 1 1 −1 1 −1 1 −1 −1 1 1 1 1 1 1 −1 |
| | −1 −1 −1 −1 −1 −1 1 1 1 −1 −1 1 −1 −1 1 −1 1 1 1 −1 −1 1 1 1 1 1 −1 1 1 −1 1 −1 |
| | −1 −1 1 1 −1 1 −1 1 1 −1 −1 1 −1 1 1 1 −1 1 −1 −1 −1 −1 1 1 1 −1 −1 1 1 1 1 1 −1 |
| | −1 −1 1 1 −1 1 1 1 1 1 1 1 1 −1 1 1 −1 −1 1 −1 −1 1 1 1 −1 −1 1 1 −1 1 1 −1 1 −1 |
| | 1 −1 1 1 −1 −1 1 −1 −1 1 −1 −1 −1 1 −1 −1 1 −1 −1 1 1 −1 1 −1 −1 1 −1 1 −1 1 1 |
| | 1 1 −1 −1 −1 1 −1 1 −1 −1 1 −1 1 1 −1 −1 1 −1 −1 −1 −1 1 −1 −1 1 −1 1 1 1 −1 1 |
| | 1 1 −1 1 −1 −1 −1 1 1 −1 1 1 1 1 1 −1 −1 −1 −1 1 −1 1 −1 1 1 −1 −1 1 −1 1 1 −1 1 |
| | −1 −1 −1 1 1 1 1 −1 −1 1 1 −1 −1 −1 −1 −1 −1 1 −1 −1 −1 −1 1 1 −1 1 −1 1 −1 −1 |
| | 1 −1 −1 1 1 1 −1 1 1 −1 −1 −1 −1 −1 1 1 −1 1 1 −1 −1 −1 −1 1 −1 −1 1 −1 1 1 −1 |
| | 1 −1 1 1 1 −1 −1 −1 1 1 −1 −1 −1 −1 −1 −1 1 −1 1 1 1 1 1 1 −1 −1 1 1 −1 −1 −1 1 |
| | −1 −1 −1 −1 1 −1 1 1 −1 1 −1 1 −1 −1 −1 1 1 −1 −1 1 1 1 −1 −1 −1 1 1 1 1 −1 −1 |
| | −1 −1 −1 1 1 1 1 1 −1 1 −1 −1 −1 1 −1 −1 1 1 −1 1 1 1 1 −1 1 −1 −1 −1 1 1 −1 −1 |
| | 1 1 −1 1 1 −1 1 −1 −1 1 −1 1 −1 1 −1 −1 −1 −1 −1 1 −1 −1 1 1 −1 −1 −1 −1 −1 1 1 |
| | 1 −1 1 1 1 1 1 −1 1 1 1 −1 1 1 1 1 −1 −1 −1 −1 1 −1 1 1 1 1 1 −1 −1 −1 −1 1 1 −1 |
| | 1 1 1 1 1 1 −1 −1 1 1 1 1 1 1 −1 1 1 −1 1 1 1 −1 −1 −1 1 −1 1 −1 −1 −1 −1 1 −1 −1 |
| | 1 1 1 −1 1 1 −1 1 1 1 −1 1 −1 1 1 1 1 −1 1 −1 −1 1 1 −1 −1 1 −1 1 −1 −1 −1 1 1 1 |
| | −1 1 1 −1 −1 −1 1 −1 1 −1 −1 −1 1 1 −1 1 1 −1 1 1 1 −1 1 −1 −1 −1 −1 1 −1 −1 1 |
| | −1 1 −1 −1 1 1 1 −1 1 1 −1 1 −1 −1 1 1 −1 −1 −1 1 1 1 1 1 −1 −1 −1 1 1 1 −1 −1 1 |
| | 1 −1 −1 1 1 1 1 −1 −1 1 −1 1 1 1 1 −1 1 1 1 −1 −1 1 −1 −1 −1 −1 −1 −1 1 −1 −1 1 |
| | 1 1 −1 1 −1 1 −1 1 1 1 −1 −1 1 −1 1 −1 −1 −1 1 1 −1 1 −1 1 −1 1 1 1 −1 −1 −1 1 |
| | −1 −1 −1 1 −1 1 −1 −1 −1 −1 −1 −1 −1 −1 1 −1 −1 −1 1 1 −1 −1 −1 1 1 −1 1 −1 1 |
| | −1 −1 1 1 1 −1 1 1 1 −1 1 −1 1 −1 1 −1 −1 −1 1 −1 1 −1 1 1 1 1 1 −1 1 1 1 −1 −1 |
| | −1 −1 1 −1 1 1 −1 1 1 1 −1 1 −1 −1 1 1 −1 −1 −1 −1 1 1 −1 1 1 −1 1 1 −1 −1 1 1 |
| | −1 1 −1 −1 −1 1 −1 1 −1 1 −1 1 1 −1 −1 −1 1 −1 −1 1 1 1 −1 1 1 1 −1 −1 1 −1 −1 |
| | 1 1 1 −1 1 1 1 1 1 −1 −1 −1 −1 −1 1 −1 −1 1 −1 1 −1 1 1 1 −1 −1 −1 1 1 1 1 1 −1 |
| | −1 1 −1 −1 1 −1 1 −1 1 −1 1 1 −1 1 −1 1 1 −1 −1 1 −1 −1 −1 −1 −1 1 1 1 −1 −1 −1 |
| | 1 −1 −1 1 −1 −1 −1 1 1 1 1 1 1 −1 −1 1 −1 1 −1 1 −1 1 1 1 1 −1 −1 1 1 −1 −1 −1 1 |
| | 1 1 1 −1 1 1 −1 1 −1 −1 −1 −1 −1 1 1 −1 −1 −1 −1 −1 −1 −1 −1 1 −1 1 −1 1 −1 −1 |
| | 1 −1 −1 1 1 −1 1 −1 1 −1 1 1 −1 −1 −1 1 1 1 −1 1 1 1 −1 1 1 1 −1 −1 −1 1 −1 −1 |
| | −1 −1 1 −1 −1 −1 1 1 −1 −1 1 −1 −1 −1 1 1 −1 −1 −1 −1 1 −1 −1 −1 −1 −1 1 1 −1 |
| | −1 1 −1 −1 1 −1 1 1 1 1 1 −1 1 1 −1 −1 −1 1 −1 −1 −1 −1 1 1 −1 −1 −1 1 1 −1 −1 |
| | −1 1 1 −1 −1 1 −1 −1 −1 −1 −1 1 −1 −1 1 −1 −1 −1 1 −1 1 1 −1 1 1 −1 −1 −1 −1 1 |
| | −1 1 −1 1 1 1 1 −1 −1 1 −1 1 1 −1 1 −1 −1 1 −1 −1 1 1 1 1 1 1 1 −1 1 −1 1 1 −1 1 |
| | −1 −1 1 −1 −1 −1 −1 −1 1 1 −1 −1 −1 1 1 1 −1 −1 −1 1 1 −1 −1 −1 1 1 1 1 −1 −1 |
| | −1 1 1 −1 1 1 −1 −1 −1 1 1 −1 1 1 1 1 −1 −1 −1 1 −1 −1 −1 −1 −1 −1 −1 1 1 −1 −1 |
| | 1 1 1 1 1 −1 −1 −1 −1 −1 1 1 1 −1 −1 1 1 −1 1 1 1 −1 1 1 −1 −1 −1 −1 −1 −1 −1 1 |
| | 1 1 1 1 −1 −1 −1 −1 1 1 1 −1 −1 1 1 −1 −1 −1 −1 −1 1 −1 1 −1 −1 1 −1 1 −1 −1 −1 |
| | −1 −1 1 −1 1 1 1 1 −1 1 −1 1 1 −1 −1 1 −1 −1 1 1 1 1 1 −1 1 −1 −1 −1 −1 1 1 1 1 1 |
| | −1 1 1 −1 −1 −1 −1 1 1 −1 −1 −1 −1 −1 −1 1 1 −1 −1 1 1 −1 −1 −1 −1 −1 1 1 −1 1 |
| | −1 1 1 −1 −1 −1 1 −1 1 1 1 −1 −1 −1 1 −1 −1 1 −1 1 1 −1 1 1 −1 −1 1 −1 1 1 1 1 1 |
| | −1 1 −1 1 1 −1 1 1 1 −1 −1 −1 1 1 −1 1 −1 −1 1 −1 −1 −1 −1 1 −1 −1 −1 −1 1 −1 1 |
| | 1 1 −1 1 1 −1 1 1 1 1 1 −1 −1 1 −1 1 1 1 1 1 −1 −1 1 −1 1 −1 −1 −1 1 −1 1 −1 −1 1 |
| | 1 −1 1 1 1 −1 1 1 1 1 1 −1 −1 1 1 1 1 −1 1 −1 −1 1 1 1 −1 1 1 1 1 −1 1 1 −1 −1 1 |
| | −1 −1 −1 −1 −1 −1 −1 −1 −1 −1 1 −1 −1 −1 −1 −1 1 −1 −1 −1 −1 −1 1 1 1 1 −1 −1 |
| | −1 −1 1 1 1 −1 1 −1 −1 −1 −1 1 1 −1 1 1 1 1 −1 −1 1 −1 1 −1 −1 1 1 −1 −1 −1 1 1 |
| | −1 −1 −1 −1 −1 1 −1 1 1 1 −1 −1 1 1 1 −1 −1 1 1 1 1 −1 −1 −1 1 1 −1 −1 −1 1 −1 |
| | −1 −1 −1 −1 1 −1 −1 1 1 −1 1 −1 −1 1 1 1 −1 −1 1 −1 1 1 −1 1 −1 1 −1 1 −1 |
| | 1 −1 −1 1 1 −1 1 1 1 1 −1 −1 1 1 −1 1 −1 1 −1 1 −1 −1 −1 1 1 −1 1 1 1 −1 −1 1 −1 |
| | −1 1 −1 −1 1 1 1 −1 −1 1 −1 1 −1 1 −1 −1 1 1 −1 −1 1 1 −1 −1 1 1 −1 −1 −1 1 −1 |
| | 1 −1 −1 −1 −1 −1 1 1 1 1 −1 1 1 1 1 1 −1 1 1 −1 1 −1 1 1 −1 1 −1 −1 1 1 1 1 −1 −1 |
| | −1 −1 −1 −1 1 1 −1 1 1 1 1 −1 1 −1 1 1 −1 1 −1 1 −1 1 −1 −1 1 1 1 1 1 −1 1 1 −1 |
| | −1 1 1 −1 1 −1 1 1 −1 −1 1 1 −1 −1 1 −1 −1 1 −1 −1 1 1 −1 1 1 1 −1 −1 1 1 −1 1 1 |
| | −1 −1 1 −1 −1 1 −1 1 −1 1 1 −1 −1 −1 1 1 −1 1 −1 1 1 1 −1 1 1 1 −1 1 1 1 1 1 1 1 |
| | −1 1 1 −1 1 1 −1 1 1 −1 1 1 −1 −1 −1 1 −1 −1 −1 1 −1 −1 −1 −1 1 −1 1 −1 1 −1 −1 |
| | 1 1 1 −1 1 −1 −1 1 1 −1 −1 1 1 −1 1 −1 −1 −1 −1 1 −1 −1 1 1 −1 1 −1 1 −1 −1 −1 |
| | 1 −1 −1 −1 −1 1 −1 −1 1 −1 −1 −1 −1 −1 1 −1 −1 −1 1 1 −1 1 1 −1 1 −1 −1 1 1 −1 |
| | 1 1 −1 1 1 −1 −1 −1 −1 1 1 −1 1 1 1 −1 −1 −1 −1 −1 −1 −1 1 1 −1 1 1 1 −1 1 −1 |
| | −1 1 −1 1 1 −1 −1 −1 −1 −1 1 −1 −1 −1 1 1 1 −1 −1 −1 1 1 1 1 1 1 1 −1 −1 −1 −1 |
| | 1 1 −1 −1 −1 −1 1 1 −1 1 −1 1 −1 1 −1 1 −1 1 −1 −1 −1 1 −1 −1 1 −1 1 1 −1 −1 −1 |
| | 1 −1 1 1 −1 1 1 −1 1 1 1 1 −1 −1 1 1 1 −1 1 1 −1 −1 1 −1 −1 −1 1 1 1 −1 −1 1 1 1 |
| | −1 1 −1 1 −1 −1 1 1 1 −1 −1 −1 −1 −1 1 1 −1 −1 1 1 −1 1 1 1 −1 1 −1 1 1 −1 −1 1 |
| | 1 −1 1 −1 1 −1 1 1 1 1 1 1 1 −1 1 1 1 −1 −1 −1 1 −1 1 1 1 1 −1 1 1 1 1 1 −1 −1 −1 |
| | 1 1 −1 −1 −1 −1 1 1 −1 −1 1 −1 −1 1 1 −1 −1 1 1 −1 1 1 1 1 −1 1 1 1 1 1 1 1 1 1 1 |
| | 1 1 −1 −1 −1 1 1 −1 −1 1 1 −1 1 −1 1 −1 −1 −1 −1 1 1 −1 −1 −1 1 −1 1 1 −1 1 −1 |
| | 1 −1 1 1 −1 1 −1 −1 1 1 1 −1 1 1 −1 −1 −1 1 −1 −1 1 1 −1 1 −1 1 1 1 1 1 −1 1 1 |
| | −1 1 1 −1 −1 −1 1 1 1 1 1 −1 1 1 −1 1 1 1 1 1 1 1 −1 −1 1 −1 −1 1 1 1 −1 −1 −1 −1 |
| | 1 1 1 1 −1 −1 1 1 1 −1 −1 1 −1 1 1 1 −1 1 1 −1 −1 1 1 −1 1 1 −1 −1 −1 −1 −1 −1 |
| | −1 −1 −1 −1 1 1 1 1 −1 −1 −1 1 −1 −1 1 −1 −1 1 −1 −1 1 1 −1 −1 −1 −1 −1 −1 −1 |
| | −1 −1 1 −1 −1 1 1 1 1 −1 1 1 −1 −1 −1 1 −1 1 1 1 1 1 1 1 −1 1 −1 −1 1 −1 −1 −1 1 |
| | 1 1 −1 1 1 1 −1 −1 −1 −1 −1 −1 1 −1 −1 −1 1 −1 −1 −1 1 1 −1 −1 −1 −1 −1 1 1 −1 |
| | −1 1 −1 1 −1 1 1 1 −1 −1 1 −1 −1 1 1 −1 1 −1 1 1 −1 −1 −1 −1 1 −1 1 1 1 1 −1 1 1 |
| | −1 −1 −1 −1 −1 1 −1 1 −1 1 −1 1 1 −1 1 1 −1 −1 −1 −1 −1 1 −1 −1 1 −1 −1 1 −1 1 |
| | 1 1 1 −1 1 −1 1 −1 1 1 −1 1 −1 1 1 −1 1 1 1 1 1 1 1 1 1 −1 −1 −1 −1 −1 1 −1 1 |
| | −1 1 1 −1 −1 −1 1 −1 1 −1 −1 1 −1 −1 −1 1 −1 1 1 1 −1 −1 −1 −1 1 1 1 −1 −1 −1 |
| | −1 1 −1 −1 1 1 1 −1 −1 −1 1 1 1 −1 1 1 −1 −1 1 −1 1 1 −1 1 1 1 1 1 1 −1 −1 −1 −1 |
| | −1 1 1 −1 1 1 1 1 1 −1 1 1 1 1 −1 −1 1 1 1 1 −1 −1 −1 −1 1 1 −1 −1 −1 1 −1 −1 1 |
| | −1 −1 −1 −1 1 1 −1 1 −1 −1 1 1 1 −1 1 −1 1 1 1 1 −1 −1 1 1 1 1 1 1 1 −1 −1 −1 1 |
| | −1 −1 −1 −1 1 1 1 1 1 1 1 1 1 −1 1 −1 −1 1 1 1 1 1 1 −1 1 1 1 −1 −1 1 −1 1 1 1 −1 |
| | −1 −1 1 −1 1 −1 1 1 1 1 −1 1 −1 1 1 1 1 −1 −1 −1 −1 −1 1 1 −1 −1 −1 −1 1 1 1 −1 |
| | 1 1 −1 −1 1 1 −1 −1 −1 1 −1 −1 1 1 −1 −1 1 −1 1 1 −1 −1 −1 1 −1 −1 −1 1 1 1 1 |
| | −1 1 1 −1 −1 1 1 −1 −1 1 −1 1 −1 1 −1 1 −1 1 1 1 −1 −1 1 1 −1 1 −1 −1 −1 −1 −1 |
| | 1 1 1 1 1 −1 −1 1 1 −1 1 1 1 1 1 1 1 −1 1 −1 1 −1 1 −1 −1 −1 −1 1 −1 −1 1 −1 −1 1 |
| | 1 1 1 −1 1 1 1 1 1 1 −1 −1 −1 1 1 −1 1 −1 −1 −1 1 1 −1 −1 −1 1 −1 −1 1 1 1 1 −1 |
| | −1 1 −1 1 −1 −1 −1 −1 1 −1 −1 −1 −1 −1 −1 1 −1 1 1 1 −1 −1 −1 −1 −1 −1 −1 −1 |
| | −1 1 1 1 −1 1 1 −1 1 1 1 1 −1 1 1 1 −1 −1 −1 1 1 −1 −1 1 1 1 −1 1 1 −1 1 1 −1 1 |
| | −1 −1 1 −1 −1 1 −1 −1 −1 1 1 −1 1 1 −1 −1 1 1 1 1 1 −1 1 −1 −1 1 1 −1 1 1 −1 −1 |
| | −1 1 −1 −1 1 −1 1 −1 −1 1 −1 −1 1 1 1 1 −1 −1 −1 −1 1 1 −1 1 −1 −1 −1 1 1 1 1 1 |
| | 1 −1 1 −1 1 1 −1 −1 1 1 1 −1 1 1 −1 −1 −1 1 1 −1 1 −1 −1 −1 −1 −1 1 −1 −1 −1 1 |
| | −1 1 −1 1 −1 −1 1 −1 1 −1 −1 −1 1 1 −1 −1 1 −1 −1 1 −1 −1 −1 −1 1 1 1 −1 1 −1 1 |
| | −1 −1 −1 1 1 1 −1 1 −1 1 1 −1 1 1 −1 −1 −1 1 1 −1 −1 −1 −1 1 −1 1 1 1 −1 1 −1 1 |
| | −1 1 1 −1 −1 −1 −1 −1 −1 −1 1 −1 −1 −1 1 −1 1 1 −1 1 −1 1 1 −1 −1 −1 1 1 −1 −1 |
| | 1 −1 1 1 1 −1 1 1 1 1 −1 1 −1 −1 −1 −1 −1 1 −1 1 −1 1 1 1 1 1 1 −1 −1 1 −1 1 1 −1 |
| | 1 1 1 −1 −1 −1 −1 −1 1 1 −1 1 −1 −1 −1 1 −1 −1 −1 1 1 1 −1 −1 1 −1 −1 1 1 −1 −1 |
| | 1 −1 1 −1 1 1 −1 1 1 1 −1 1 −1 1 −1 −1 −1 −1 1 1 1 1 1 1 −1 −1 −1 −1 1 1 1 1 1 −1 |
| | 1 −1 1 1 −1 −1 −1 −1 −1 −1 1 −1 1 −1 −1 −1 1 1 1 1 1 1 1 −1 1 1 1 1 1 1 1 −1 −1 |
| | −1 1 1 1 1 −1 1 −1 −1 1 1 −1 1 −1 1 1 −1 1 1 1 1 −1 −1 −1 1 −1 −1 1 1 1 1 1 |
| | −1 −1 1 −1 −1 −1 1 −1 −1 1 1 −1 1 −1 −1 −1 −1 1 1 1 −1 1 −1 −1 1 1 −1 1 −1 −1 |
| | −1 1 1 1 −1 −1 −1 −1 1 1 −1 1 −1 1 1 −1 1 1 −1 −1 1 −1 −1 −1 −1 1 1 1 −1 −1 1 |
| | −1 −1 −1 1 −1 1 1 1 1 1 1 −1 1 −1 −1 −1 −1 1 −1 −1 −1 1 −1 −1 −1 −1 −1 1 −1 −1 |
| | 1 1 1 1 1 −1 −1 −1 −1 1 −1 −1 1 −1 1 −1 1 −1 −1 1 −1 −1 −1 −1 1 1 −1 −1 1 1 1 1 |
| | −1 1 1 −1 −1 1 −1 1 1 1 −1 −1 1 1 −1 −1 −1 −1 1 −1 1 1 −1 1 −1 −1 1 1 −1 1 −1 1 |
| | −1 1 −1 1 1 −1 1 −1 −1 −1 1 −1 1 1 1 −1 −1 1 1 −1 1 1 1 1 −1 −1 −1 −1 1 1 −1 −1 |
| | 1 1 −1 1 −1 −1 1 1 −1 −1 −1 −1 −1 −1 1 1 1 1 −1 1 −1 1 1 −1 −1 −1 1 1 1 1 −1 −1 |
| | 1 −1 −1 −1 1 −1 1 −1 −1 −1 1 1 1 −1 −1 −1 1 −1 −1 −1 1 1 −1 1 −1 −1 1 1 −1 −1 1 |
| | 1 1 −1 1 −1 −1 1 −1 −1 −1 −1 1 1 1 1 −1 1 1 −1 1 1 1 1 −1 −1 −1 −1 −1 −1 1 −1 1 |
| | −1 1 1 −1 1 1 −1 −1 1 1 1 1 −1 1 −1 −1 −1 −1 −1 −1 1 −1 −1 1 −1 −1 1 1 −1 −1 1 |
| | 1 1 −1 −1 1 1 1 −1 1 1 −1 1 −1 1 −1 −1 −1 −1 1 −1 1 1 −1 1 1 −1 1 −1 −1 −1 −1 |
| | −1 −1 −1 1 −1 −1 1 1 −1 −1 1 1 1 1 1 −1 1 1 1 −1 1 −1 −1 −1 −1 −1 1 1 1 −1 −1 1 |
| | −1 1 −1 1 1 1 −1 1 −1 1 −1 1 −1 1 1 −1 −1 1 1 −1 1 1 −1 1 1 1 −1 −1 1 1 −1 −1 −1 |
| | 1 −1 1 1 1 1 −1 −1 −1 −1 1 1 1 1 −1 1 −1 −1 1 −1 1 −1 −1 1 −1 1 1 1 −1 1 1 −1 1 |
| | −1 −1 −1 1 −1 1 −1 −1 1 −1 1 −1 1 1 1 −1 1 1 −1 1 1 −1 −1 −1 −1 −1 −1 1 1 1 −1 |
| | 1 −1 −1 1 −1 1 −1 −1 −1 1 −1 1 1 1 −1 1 −1 −1 −1 1 −1 −1 1 −1 1 −1 1 1 −1 1 1 |
| | −1 1 −1 −1 1 1 1 −1 −1 −1 1 −1 1 −1 −1 1 1 −1 −1 −1 −1 −1 1 −1 −1 1 1 1 −1 −1 1 |
| | −1 −1 1 −1 −1 −1 −1 −1 −1 −1 −1 1 1 −1 −1 −1 1 1 −1 1 1 −1 1 −1 1 −1 −1 −1 1 |
| | −1 1 1 1 1 −1 1 −1 −1 −1 1 −1 1 1 1 1 1 −1 1 −1 −1 −1 1 1 1 −1 1 −1 −1 −1 1 1 1 1 |
| | 1 −1 1 −1 −1 1 −1 1 −1 1 −1 1 1 1 −1 1 1 1 1 1 1 −1 1 −1 1 −1 −1 −1 −1 1 −1 −1 |
| | −1 1 1 1 1 −1 −1 −1 1 −1 1 −1 1 −1 1 1 1 1 1 1 −1 1 −1 1 1 1 1 −1 1 1 1 −1 1 −1 1 |
| | −1 −1 1 1 −1 1 1 −1 −1 1 −1 1 −1 1 1 −1 −1 −1 −1 −1 1 1 −1 −1 −1 1 −1 −1 1 −1 |
| | −1 −1 −1 −1 −1 1 1 −1 1 −1 1 1 1 1 1 1 −1 −1 −1 1 −1 1 −1 −1 −1 1 −1 1 −1 1 −1 |
| | −1 −1 1 −1 −1 −1 1 −1 1 −1 1 1 1 −1 −1 1 1 1 −1 1 −1 −1 1 1 1 1 −1 1 −1 −1 1 −1 |
| | −1 1 1 1 −1 −1 −1 1 −1 −1 1 1 1 1 1 1 −1 −1 1 1 1 −1 −1 −1 −1 1 −1 1 1 1 −1 −1 1 |
| | −1 −1 1 −1 1 −1 −1 1 −1 1 −1 −1 1 1 1 1 −1 −1 −1 1 1 1 1 1 1 −1 1 1 −1 −1 −1 −1 |
| | −1 −1 1 −1 −1 1 1 −1 1 −1 −1 1 1 −1 1 1 1 −1 −1 −1 −1 1 1 1 1 1 1 −1 1 1 1 1 1 −1 |
| | −1 1 −1 −1 −1 −1 1 1 1 1 1 −1 −1 −1 1 −1 −1 1 −1 1 −1 1 −1 1 −1 1 −1 −1 1 −1 1 |
| | −1 1 1 −1 1 −1 1 −1 −1 −1 −1 −1 1 −1 1 −1 −1 −1 −1 1 1 −1 1 −1 1 1 1 −1 −1 −1 |
| | −1 −1 1 −1 −1 1 1 −1 1 1 1 −1 1 −1 −1 −1 1 −1 1 −1 1 1 −1 −1 −1 −1 1 −1 −1 −1 |
| | −1 1 −1 −1 −1 −1 −1 1 −1 1 1 1 −1 1 −1 −1 1 −1 1 −1 1 1 −1 −1 1 −1 −1 −1 1 1 −1 |
| | 1 1 1 1 −1 1 1 −1 −1 −1 1 1 −1 −1 1 1 −1 −1 1 −1 −1 −1 1 1 1 1 1 −1 1 1 1 −1 −1 1 |
| | 1 −1 −1 1 −1 1 1 1 −1 −1 −1 −1 1 −1 −1 1 −1 −1 1 −1 −1 −1 −1 1 −1 −1 1 1 −1 −1 |
| | 1 −1 −1 −1 1 −1 −1 −1 1 −1 −1 −1 1 −1 1 1 −1 −1 1 −1 1 −1 1 1 1 1 1 −1 −1 −1 −1 |
| | −1 −1 1 1 1 −1 −1 1 1 1 −1 −1 1 −1 −1 −1 −1 −1 1 −1 1 −1 1 −1 −1 −1 1 1 1 1 1 |
| | −1 −1 1 1 1 −1 −1 1 1 −1 −1 1 −1 −1 −1 −1 −1 −1 1 1 1 −1 1 1 1 −1 −1 1 1 1 −1 1 |
| | 1 1 −1 1 1 −1 1 1 −1 1 1 1 −1 −1 −1 −1 1 −1 −1 −1 1 1 1 −1 1 1 −1 1 1 −1 −1 1 1 1 |
| | −1 1 −1 −1 −1 1 1 −1 −1 −1 −1 1 1 1 1 −1 −1 −1 −1 −1 −1 −1 −1 1 1 1 −1 −1 −1 1 |
| | 1 1 −1 −1 −1 1 −1 1 1 −1 1 −1 −1 1 −1 1 −1 −1 1 1 −1 −1 1 −1 −1 −1 −1 1 1 −1 1 |
| | 1 1 −1 1 1 1 −1 −1 1 −1 1 −1 −1 1 −1 −1 −1 1 1 −1 −1 1 −1 1 1 −1 1 −1 1 1 −1 1 1 |
| | −1 1 −1 1 −1 −1 1 −1 1 1 1 −1 −1 −1 1 1 −1 1 1 1 −1 −1 −1 1 1 1 −1 1 −1 1 1 1 −1 |
| | −1 −1 −1 1 −1 1 −1 1 −1 1 1 1 −1 −1 −1 −1 1 1 −1 1 1 −1 −1 −1 1 −1 1 −1 1 1 −1 |
| | 1 −1 −1 −1 −1 1 −1 1 1 1 1 1 1 1 1 −1 1 −1 1 1 1 −1 1 −1 1 1 1 −1 −1 1 1 −1 −1 1 |
| | 1 −1 −1 1 −1 1 1 −1 1 1 −1 −1 −1 1 −1 1 1 −1 −1 −1 1 1 1 −1 −1 −1 −1 −1 1 −1 −1 |
| | −1 −1 1 1 1 −1 1 1 −1 1 −1 −1 −1 −1 1 −1 −1 −1 −1 1 1 −1 −1 1 −1 −1 −1 −1 1 −1 |
| | 1 −1 1 1 1 −1 1 1 1 −1 −1 −1 −1 1 1 −1 −1 −1 1 −1 −1 −1 1 1 −1 −1 1 1 1 1 1 1 1 1 |
| | −1 −1 −1 −1 1 −1 1 1 −1 −1 −1 −1 −1 1 1 1 1 1 1 −1 1 −1 −1 −1 1 −1 1 −1 −1 −1 1 |
| | −1 −1 1 −1 −1 −1 1 −1 −1 −1 1 1 1 1 1 |
| 3 | −1 −1 −1 −1 −1 −1 −1 −1 −1 −1 −1 −1 −1 1 −1 −1 −1 −1 −1 1 1 1 1 1 −1 1 1 −1 |
| | −1 1 −1 −1 1 1 −1 1 −1 −1 1 1 1 1 −1 1 −1 −1 1 1 1 1 1 1 −1 1 1 1 −1 −1 −1 1 −1 |
| | −1 1 1 −1 1 −1 1 −1 −1 −1 1 −1 −1 −1 1 1 1 −1 −1 −1 1 −1 1 −1 −1 −1 −1 −1 −1 |
| | −1 1 1 1 1 1 1 −1 −1 1 −1 1 1 −1 −1 1 −1 −1 1 1 1 1 1 −1 1 1 −1 −1 −1 1 −1 1 1 −1 |
| | −1 −1 −1 1 1 −1 −1 −1 −1 −1 1 −1 1 −1 1 −1 −1 1 1 −1 1 −1 −1 1 −1 1 −1 −1 1 −1 |
| | 1 −1 1 1 1 −1 1 1 −1 −1 −1 −1 1 1 −1 1 −1 1 −1 1 −1 −1 1 1 −1 −1 −1 1 1 −1 1 1 1 |
| | 1 −1 1 1 1 −1 −1 1 −1 1 1 1 1 1 1 1 1 −1 1 1 −1 −1 −1 −1 −1 −1 1 −1 −1 1 1 1 1 −1 |
| | 1 −1 1 1 −1 1 1 1 −1 1 1 1 1 1 −1 1 −1 1 1 1 −1 1 −1 1 1 −1 1 1 −1 −1 −1 1 1 1 −1 |
| | 1 1 −1 1 −1 1 1 −1 1 −1 1 1 −1 −1 1 −1 −1 −1 −1 −1 −1 1 −1 −1 1 1 −1 −1 −1 1 −1 |
| | 1 −1 −1 1 1 1 1 −1 1 −1 1 −1 1 1 1 1 −1 −1 1 1 1 1 1 −1 −1 −1 1 −1 1 1 1 1 −1 1 |
| | −1 1 1 −1 −1 1 −1 −1 1 1 −1 −1 1 −1 1 1 1 −1 −1 1 −1 −1 −1 −1 1 −1 1 −1 1 1 −1 |
| | 1 1 1 1 1 1 −1 1 1 −1 1 1 1 −1 −1 1 −1 −1 1 −1 1 1 1 −1 −1 −1 1 1 1 −1 1 1 1 1 1 |
| | 1 1 −1 −1 1 1 1 −1 1 1 1 1 1 1 −1 1 −1 1 1 1 1 1 1 1 1 −1 −1 −1 −1 −1 −1 −1 1 −1 |
| | 1 −1 −1 −1 −1 1 −1 −1 −1 1 1 −1 −1 −1 −1 −1 −1 −1 1 1 1 −1 1 −1 −1 −1 1 1 −1 1 |
| | −1 −1 −1 −1 1 −1 −1 −1 1 −1 1 −1 −1 −1 −1 1 −1 1 1 1 1 −1 −1 1 −1 −1 −1 −1 −1 |
| | −1 1 1 1 1 1 −1 −1 1 1 −1 1 −1 1 −1 1 −1 1 1 −1 −1 −1 −1 −1 −1 −1 1 1 −1 1 1 −1 |
| | −1 −1 −1 1 −1 1 −1 1 1 −1 −1 −1 1 1 1 1 1 1 1 1 −1 −1 −1 1 1 −1 −1 1 −1 −1 −1 |
| | −1 −1 −1 −1 1 −1 1 1 −1 1 −1 1 −1 1 1 1 1 −1 1 −1 1 1 1 1 1 −1 −1 1 −1 −1 −1 1 |
| | −1 −1 −1 1 1 −1 −1 1 −1 1 −1 −1 1 −1 −1 −1 1 −1 1 −1 −1 −1 1 −1 −1 1 1 1 −1 −1 |
| | −1 1 −1 1 1 −1 1 −1 −1 −1 1 −1 1 1 1 −1 1 1 1 −1 1 1 −1 1 1 −1 −1 −1 −1 −1 −1 1 |
| | 1 1 1 1 1 1 1 1 −1 1 1 1 −1 1 −1 −1 −1 −1 1 −1 1 1 1 −1 1 −1 1 1 −1 −1 −1 −1 |
| | 1 −1 −1 −1 1 −1 −1 −1 1 −1 −1 1 1 −1 1 1 1 1 −1 −1 1 1 1 −1 1 1 −1 −1 1 1 −1 1 1 |
| | 1 1 1 1 −1 −1 1 −1 −1 1 1 −1 1 −1 1 −1 1 1 1 −1 −1 −1 −1 1 1 −1 −1 1 −1 −1 −1 |
| | −1 1 1 −1 1 −1 1 −1 −1 1 −1 1 1 −1 1 −1 1 1 −1 −1 −1 1 −1 −1 −1 −1 1 1 −1 −1 1 |
| | −1 1 −1 1 1 1 −1 −1 1 1 −1 −1 −1 −1 −1 −1 1 −1 −1 −1 −1 1 1 −1 1 1 1 1 −1 1 −1 |
| | −1 −1 −1 1 −1 −1 1 1 1 1 −1 −1 1 1 1 −1 1 −1 1 −1 1 1 −1 −1 1 1 1 1 −1 1 −1 −1 |
| | −1 1 −1 1 1 1 1 −1 1 1 −1 1 −1 −1 1 1 −1 1 1 −1 1 −1 −1 −1 1 −1 1 −1 −1 −1 1 1 1 |
| | 1 1 1 −1 1 −1 1 −1 1 −1 1 1 1 −1 1 −1 −1 −1 1 −1 1 −1 1 −1 −1 1 1 1 −1 −1 −1 1 |
| | −1 −1 −1 −1 1 −1 −1 1 1 −1 1 1 −1 1 1 −1 1 1 −1 1 1 1 −1 1 1 −1 1 −1 −1 1 −1 −1 |
| | −1 1 −1 1 1 1 −1 1 −1 −1 −1 1 1 −1 −1 1 −1 −1 −1 1 1 −1 −1 1 −1 −1 1 −1 1 −1 −1 |
| | 1 1 −1 1 −1 1 1 1 1 −1 −1 −1 1 1 −1 1 −1 1 1 −1 −1 1 −1 1 1 −1 −1 −1 1 1 −1 1 1 |
| | −1 1 1 1 1 1 1 1 1 −1 1 −1 1 −1 −1 −1 −1 1 1 −1 −1 1 −1 −1 1 1 1 1 −1 1 1 1 −1 −1 |
| | 1 1 −1 1 1 1 1 −1 1 1 −1 1 −1 1 −1 1 −1 1 1 1 1 −1 −1 −1 −1 1 1 1 −1 1 −1 1 −1 1 |
| | −1 −1 1 1 1 1 −1 1 1 −1 −1 1 1 1 −1 −1 −1 1 1 −1 −1 1 1 −1 1 −1 −1 −1 1 −1 −1 1 |
| | 1 1 1 1 −1 1 −1 1 −1 −1 1 −1 −1 1 −1 −1 −1 1 −1 1 1 −1 1 1 −1 −1 −1 −1 1 −1 −1 |
| | 1 1 1 −1 −1 1 1 1 1 1 −1 −1 1 −1 −1 1 1 1 −1 −1 1 −1 1 −1 1 −1 −1 −1 1 −1 1 1 −1 |
| | −1 1 −1 1 −1 −1 −1 1 1 1 1 −1 −1 −1 1 −1 1 1 1 −1 1 1 −1 1 1 1 −1 1 −1 −1 −1 −1 |
| | −1 1 1 1 −1 1 −1 −1 1 −1 1 −1 1 −1 1 −1 −1 1 −1 1 1 1 1 1 1 1 −1 1 1 1 −1 −1 1 −1 |
| | −1 −1 1 1 1 1 −1 1 −1 1 1 1 1 −1 1 −1 1 −1 −1 1 1 −1 −1 −1 −1 −1 −1 1 1 1 −1 −1 |
| | 1 1 1 1 1 1 1 1 −1 −1 1 −1 1 −1 −1 1 1 −1 −1 −1 −1 1 1 1 1 1 −1 1 1 1 1 1 −1 −1 1 |
| | −1 −1 1 −1 −1 −1 −1 1 −1 −1 −1 1 −1 −1 1 −1 −1 −1 1 1 1 1 1 1 1 1 1 1 −1 1 1 −1 |
| | 1 1 −1 −1 −1 1 1 −1 1 1 1 −1 1 1 1 1 −1 1 1 −1 1 1 −1 −1 1 −1 1 −1 1 1 −1 −1 1 1 |
| | 1 −1 1 1 −1 −1 −1 −1 −1 1 1 1 −1 1 1 −1 −1 −1 1 −1 −1 1 1 −1 −1 −1 −1 −1 −1 −1 |
| | −1 1 −1 −1 1 −1 1 1 1 1 −1 −1 −1 1 1 1 −1 −1 1 1 −1 1 1 −1 1 1 1 1 −1 −1 1 1 −1 1 |
| | 1 1 −1 −1 −1 1 −1 1 1 −1 −1 1 −1 −1 1 −1 −1 1 1 −1 1 −1 −1 −1 −1 1 1 −1 1 1 −1 |
| | 1 1 1 −1 −1 1 1 1 −1 −1 −1 1 −1 −1 1 1 1 −1 −1 1 −1 −1 1 1 −1 −1 −1 −1 −1 1 1 |
| | −1 1 −1 −1 −1 −1 1 1 1 −1 1 −1 1 1 −1 −1 −1 1 1 −1 1 −1 1 1 1 1 1 −1 1 1 1 −1 −1 |
| | 1 1 1 −1 1 1 1 −1 −1 1 −1 1 −1 −1 1 1 1 1 −1 −1 1 1 −1 1 1 −1 1 −1 −1 1 −1 −1 1 |
| | −1 −1 1 1 1 1 1 −1 −1 −1 −1 −1 −1 1 1 1 1 −1 −1 1 1 1 −1 −1 1 1 −1 1 1 1 −1 1 1 1 |
| | −1 1 1 1 −1 1 −1 −1 −1 1 −1 −1 1 1 −1 −1 1 −1 1 −1 −1 −1 −1 1 −1 1 −1 −1 1 −1 |
| | −1 1 1 −1 −1 −1 −1 1 −1 1 −1 1 −1 1 −1 −1 1 1 −1 1 1 1 1 −1 1 −1 1 1 −1 1 −1 −1 |
| | −1 1 1 1 −1 1 −1 1 −1 −1 −1 1 1 1 1 −1 1 1 1 −1 1 1 −1 −1 1 1 −1 −1 −1 1 1 1 1 1 |
| | −1 1 −1 −1 −1 −1 −1 −1 −1 −1 1 1 −1 1 1 1 1 −1 −1 1 −1 −1 −1 1 1 −1 1 1 1 −1 1 |
| | −1 −1 1 −1 1 1 1 1 1 −1 −1 −1 1 1 1 1 −1 1 −1 −1 1 −1 1 −1 1 1 −1 −1 −1 1 −1 −1 |
| | 1 1 1 1 −1 −1 −1 −1 1 −1 1 −1 −1 −1 1 1 −1 1 −1 1 −1 1 1 −1 −1 1 −1 −1 1 −1 1 |
| | −1 1 −1 1 −1 1 −1 −1 1 1 1 −1 1 1 1 −1 −1 −1 1 1 −1 −1 1 −1 1 1 −1 −1 −1 −1 −1 |
| | −1 1 1 −1 −1 1 1 1 1 −1 −1 1 1 1 1 −1 −1 1 −1 1 −1 −1 −1 1 1 −1 −1 −1 −1 −1 1 1 |
| | 1 1 1 −1 −1 −1 −1 −1 1 −1 1 1 1 −1 1 1 1 1 −1 1 −1 1 1 1 −1 −1 −1 −1 1 −1 1 −1 1 |
| | −1 −1 1 −1 1 1 −1 −1 1 1 1 −1 −1 1 1 −1 −1 −1 1 −1 1 1 −1 −1 1 1 1 1 −1 −1 1 −1 |
| | −1 1 −1 −1 1 1 1 −1 −1 −1 −1 −1 −1 1 −1 1 1 1 −1 1 −1 −1 1 −1 1 −1 −1 1 1 −1 −1 |
| | 1 1 1 1 1 1 −1 −1 1 1 1 −1 −1 −1 1 1 1 1 1 1 −1 1 1 −1 −1 1 −1 1 −1 1 −1 1 −1 1 1 |
| | 1 1 1 1 −1 −1 1 1 −1 −1 1 −1 1 1 −1 −1 1 1 −1 −1 1 1 1 −1 1 1 1 −1 1 −1 −1 1 −1 |
| | −1 −1 1 1 1 −1 1 −1 1 1 1 −1 1 1 1 −1 −1 1 1 1 1 −1 1 1 −1 −1 −1 −1 1 −1 −1 −1 |
| | −1 1 −1 −1 1 −1 1 1 1 −1 1 −1 −1 1 1 −1 −1 −1 1 1 1 −1 1 1 1 −1 −1 1 1 −1 −1 −1 |
| | 1 1 −1 1 −1 −1 1 −1 1 1 −1 −1 −1 1 −1 −1 −1 1 −1 1 −1 −1 1 1 1 −1 1 1 −1 1 −1 |
| | −1 1 1 1 −1 1 −1 1 −1 1 −1 1 −1 1 1 1 −1 −1 1 −1 −1 1 −1 −1 −1 1 −1 −1 −1 −1 1 |
| | 1 −1 1 −1 −1 1 −1 1 −1 1 −1 −1 1 −1 1 −1 1 −1 1 1 1 1 −1 1 1 −1 1 1 1 1 1 −1 1 −1 |
| | −1 1 −1 −1 1 −1 −1 −1 −1 1 1 1 −1 1 −1 −1 −1 −1 −1 −1 1 −1 −1 1 −1 1 −1 −1 1 |
| | −1 −1 −1 −1 1 1 −1 −1 −1 −1 −1 −1 1 1 −1 1 −1 1 1 1 −1 1 1 1 1 1 1 1 1 1 1 1 1 −1 |
| | −1 1 1 1 1 −1 1 1 1 1 −1 −1 1 −1 1 −1 −1 1 −1 1 −1 −1 −1 1 −1 1 1 1 −1 −1 −1 1 |
| | −1 1 1 1 1 1 −1 −1 1 1 −1 1 1 −1 −1 1 −1 1 −1 −1 −1 −1 −1 1 1 −1 −1 1 1 −1 1 1 |
| | −1 1 1 −1 −1 −1 −1 1 1 1 1 1 1 −1 1 1 1 1 1 −1 1 −1 −1 −1 1 −1 1 −1 −1 1 −1 1 1 1 |
| | 1 −1 −1 1 −1 1 1 −1 −1 −1 1 −1 1 1 1 −1 1 −1 1 1 1 1 −1 −1 −1 −1 −1 −1 1 −1 1 |
| | −1 −1 −1 1 −1 −1 −1 −1 1 −1 −1 −1 −1 −1 1 1 −1 −1 1 −1 1 1 1 −1 1 −1 −1 −1 −1 |
| | −1 −1 −1 1 −1 1 −1 1 1 −1 1 −1 −1 1 1 1 −1 −1 1 1 −1 1 −1 −1 −1 1 1 1 1 1 1 1 −1 |
| | −1 1 −1 1 1 1 1 1 −1 −1 1 −1 1 1 1 −1 −1 −1 −1 1 −1 −1 1 1 −1 −1 1 1 1 1 −1 −1 |
| | −1 −1 1 1 −1 −1 −1 −1 1 −1 −1 1 −1 1 1 −1 1 1 −1 −1 1 −1 −1 −1 −1 1 −1 −1 −1 |
| | −1 1 −1 1 −1 −1 1 1 1 1 1 −1 −1 1 −1 1 −1 1 1 −1 −1 −1 −1 1 −1 1 1 1 −1 −1 −1 |
| | −1 −1 −1 1 1 1 −1 1 −1 1 1 1 1 −1 1 1 −1 −1 −1 1 1 1 −1 −1 −1 −1 1 −1 1 −1 −1 1 |
| | −1 1 −1 1 −1 −1 −1 1 1 −1 1 −1 −1 1 1 1 −1 −1 −1 −1 −1 1 −1 −1 1 1 1 1 1 −1 −1 |
| | 1 1 −1 −1 1 1 −1 1 −1 −1 1 −1 −1 −1 1 1 −1 1 1 −1 1 1 −1 −1 1 1 1 1 1 1 −1 1 −1 1 |
| | 1 −1 −1 1 1 1 1 1 −1 −1 −1 −1 1 1 1 1 1 1 1 −1 1 1 1 1 1 1 −1 −1 −1 −1 1 1 1 −1 |
| | −1 1 1 −1 1 −1 1 1 1 1 1 1 −1 1 1 −1 −1 −1 1 1 −1 1 −1 −1 −1 1 1 1 −1 −1 1 1 −1 |
| | −1 −1 −1 1 1 1 −1 −1 −1 1 1 1 −1 1 −1 −1 1 1 1 1 1 −1 1 1 1 1 −1 1 −1 1 −1 −1 −1 |
| | −1 −1 −1 −1 −1 1 −1 1 1 1 1 1 1 −1 1 −1 −1 1 −1 1 1 1 −1 −1 −1 −1 −1 1 −1 1 1 |
| | −1 1 1 1 1 1 1 1 −1 1 1 −1 1 −1 1 −1 −1 1 1 1 1 1 1 −1 −1 −1 1 −1 −1 −1 −1 −1 −1 |
| | 1 1 1 −1 −1 −1 −1 1 1 1 1 −1 1 −1 −1 1 1 −1 −1 1 1 −1 1 −1 1 −1 −1 −1 −1 1 −1 |
| | −1 1 1 −1 −1 −1 −1 1 1 −1 −1 1 −1 1 1 −1 1 1 −1 −1 −1 1 −1 −1 −1 1 1 −1 −1 −1 1 |
| | 1 −1 −1 1 1 −1 −1 1 −1 −1 1 −1 1 1 1 1 1 −1 1 1 1 1 1 1 1 1 −1 −1 1 1 −1 −1 −1 1 |
| | 1 1 −1 −1 −1 1 −1 −1 1 −1 −1 −1 −1 1 −1 1 1 1 −1 −1 1 1 −1 −1 1 1 −1 −1 1 −1 1 |
| | −1 −1 1 1 1 −1 1 −1 1 1 −1 −1 1 −1 1 −1 1 −1 −1 1 1 1 1 1 −1 1 −1 −1 1 −1 1 −1 |
| | −1 −1 −1 −1 −1 1 1 −1 1 1 1 −1 1 −1 1 −1 −1 1 1 1 −1 1 −1 −1 −1 −1 −1 1 −1 −1 |
| | −1 1 −1 −1 −1 −1 1 −1 1 1 −1 −1 1 1 1 −1 1 −1 1 −1 −1 −1 −1 −1 1 1 −1 1 −1 1 −1 |
| | 1 1 1 1 1 −1 −1 1 1 1 −1 1 −1 −1 1 1 1 −1 −1 −1 1 1 1 −1 −1 1 −1 1 1 1 −1 1 −1 1 |
| | 1 −1 −1 −1 −1 −1 −1 1 −1 1 −1 1 1 1 −1 −1 −1 1 1 −1 −1 −1 1 1 1 −1 −1 1 −1 −1 |
| | −1 1 −1 1 −1 −1 1 −1 −1 −1 1 1 −1 −1 −1 −1 1 1 −1 1 1 1 1 1 −1 −1 −1 −1 −1 −1 |
| | −1 −1 1 1 −1 −1 −1 1 1 −1 −1 −1 −1 −1 −1 1 −1 1 1 −1 1 1 −1 −1 1 1 1 −1 −1 1 −1 |
| | 1 −1 −1 1 −1 −1 1 −1 −1 1 −1 −1 1 1 −1 −1 1 −1 −1 −1 1 −1 −1 1 1 −1 −1 −1 1 1 |
| | −1 −1 −1 1 1 −1 1 −1 1 −1 −1 1 1 −1 1 −1 1 −1 −1 1 −1 −1 −1 −1 1 −1 1 −1 −1 −1 |
| | −1 1 1 1 −1 1 1 −1 1 −1 −1 −1 −1 1 −1 1 −1 −1 −1 1 −1 1 1 −1 1 −1 −1 1 −1 −1 1 |
| | 1 1 1 1 1 1 −1 −1 −1 −1 −1 1 1 1 −1 1 −1 1 −1 −1 1 −1 1 1 1 −1 −1 1 1 −1 1 −1 1 |
| | −1 −1 1 1 1 −1 −1 1 −1 −1 −1 −1 −1 −1 −1 −1 1 1 1 −1 1 1 1 −1 1 1 −1 −1 −1 −1 |
| | −1 −1 −1 1 −1 1 1 1 −1 −1 1 −1 1 −1 1 1 −1 1 1 −1 1 −1 1 −1 1 −1 −1 −1 1 1 −1 |
| | −1 1 −1 1 1 1 1 −1 −1 −1 −1 −1 1 −1 −1 1 −1 −1 1 1 −1 −1 −1 1 −1 −1 1 −1 1 1 1 |
| | −1 −1 1 −1 1 1 −1 1 −1 1 1 1 1 −1 1 −1 −1 1 −1 1 1 −1 1 −1 −1 −1 −1 −1 −1 1 1 |
| | −1 −1 −1 1 −1 1 −1 −1 −1 −1 1 1 −1 1 1 1 −1 1 1 −1 −1 −1 1 1 −1 −1 1 −1 −1 1 1 |
| | −1 −1 −1 1 1 1 1 −1 1 1 −1 −1 −1 1 −1 −1 −1 −1 −1 −1 −1 −1 1 −1 −1 −1 1 1 1 1 1 |
| | 1 −1 −1 1 1 −1 1 −1 −1 1 1 −1 1 1 1 −1 −1 −1 −1 1 1 1 −1 −1 −1 −1 −1 1 −1 1 −1 |
| | 1 1 1 1 1 −1 1 1 −1 1 −1 1 1 1 1 1 1 1 −1 1 −1 −1 −1 −1 1 −1 1 −1 1 1 1 −1 1 1 1 1 |
| | −1 −1 1 1 1 1 −1 1 −1 −1 1 −1 −1 1 1 1 −1 −1 1 1 −1 −1 1 −1 −1 1 1 −1 1 1 1 1 1 1 |
| | 1 1 1 −1 −1 1 −1 −1 1 −1 1 1 −1 1 −1 −1 1 1 −1 −1 1 1 1 −1 −1 1 −1 −1 1 −1 1 −1 |
| | −1 −1 −1 −1 1 −1 1 −1 1 1 −1 −1 1 −1 1 1 1 1 −1 1 1 −1 −1 1 −1 1 1 −1 −1 1 −1 1 |
| | −1 1 1 1 1 1 1 1 −1 −1 1 −1 −1 −1 1 1 1 −1 1 1 −1 1 1 −1 1 −1 1 −1 −1 1 −1 −1 1 1 |
| | 1 −1 1 −1 1 −1 −1 1 1 −1 1 1 −1 −1 −1 1 −1 1 −1 −1 1 −1 −1 1 −1 1 −1 −1 −1 1 1 |
| | 1 −1 1 −1 −1 1 −1 −1 1 1 −1 1 −1 1 1 −1 1 1 −1 −1 1 −1 1 1 −1 1 −1 −1 1 −1 1 −1 |
| | 1 1 1 1 −1 1 −1 −1 −1 1 1 1 −1 1 1 −1 −1 −1 −1 1 −1 1 1 −1 1 −1 −1 −1 −1 1 1 1 1 |
| | −1 −1 1 1 −1 1 −1 1 1 −1 −1 1 1 −1 1 −1 −1 −1 −1 1 −1 1 1 1 −1 1 −1 1 −1 −1 1 |
| | −1 −1 −1 1 −1 −1 1 −1 −1 1 −1 1 1 1 1 −1 1 1 1 1 1 −1 1 1 1 −1 1 −1 1 1 −1 1 −1 1 |
| | −1 −1 1 1 −1 −1 1 1 −1 −1 1 1 −1 −1 −1 1 1 −1 −1 1 −1 1 −1 1 −1 −1 −1 −1 1 1 1 |
| | −1 −1 −1 −1 1 −1 −1 1 −1 1 −1 1 1 1 −1 −1 −1 −1 −1 −1 −1 −1 1 −1 1 −1 −1 1 1 1 |
| | −1 −1 −1 −1 1 −1 −1 −1 1 1 −1 1 1 −1 −1 −1 −1 −1 1 1 −1 1 1 1 −1 −1 1 1 −1 −1 1 |
| | −1 1 −1 1 −1 1 1 −1 1 1 1 1 −1 −1 −1 1 1 1 1 1 1 1 −1 1 −1 −1 1 1 1 −1 1 −1 −1 1 |
| | 1 −1 1 −1 −1 1 1 −1 −1 −1 1 −1 −1 −1 1 1 1 1 −1 1 1 −1 1 1 1 −1 −1 −1 1 −1 −1 |
| | −1 −1 −1 1 −1 1 1 −1 −1 1 −1 1 1 1 −1 1 1 1 −1 −1 −1 −1 1 1 −1 1 −1 −1 −1 −1 −1 |
| | −1 1 −1 1 −1 −1 1 −1 −1 −1 −1 −1 −1 −1 −1 −1 −1 1 −1 1 1 −1 −1 1 1 −1 1 1 −1 1 |
| | −1 1 −1 −1 −1 1 −1 1 1 1 1 1 −1 1 −1 1 −1 1 1 1 −1 1 −1 1 1 1 −1 1 −1 −1 −1 −1 1 |
| | 1 −1 1 −1 1 1 1 1 −1 1 1 1 1 −1 1 1 1 1 −1 −1 −1 1 1 −1 −1 1 1 1 −1 −1 −1 −1 1 1 |
| | −1 1 1 1 −1 −1 −1 −1 −1 −1 1 −1 −1 −1 1 −1 1 −1 1 1 −1 1 −1 1 −1 1 1 −1 −1 −1 1 |
| | −1 1 −1 1 1 1 −1 1 −1 −1 1 −1 −1 1 −1 1 1 −1 1 1 1 1 1 −1 −1 −1 1 1 −1 −1 −1 1 |
| | −1 −1 −1 −1 1 −1 1 −1 1 −1 1 1 1 1 1 −1 1 −1 1 1 −1 1 1 −1 1 1 1 1 1 −1 −1 1 −1 1 |
| | −1 −1 −1 −1 −1 −1 −1 −1 −1 1 1 1 1 1 −1 1 −1 1 −1 1 −1 −1 −1 1 −1 1 −1 1 −1 1 |
| | −1 1 1 −1 −1 1 1 −1 −1 −1 1 −1 −1 1 1 −1 1 1 −1 −1 −1 −1 1 1 −1 −1 1 1 −1 1 −1 |
| | 1 1 1 −1 −1 1 −1 1 1 1 −1 −1 1 1 1 −1 −1 1 −1 −1 −1 1 1 −1 −1 −1 1 −1 1 −1 1 1 |
| | −1 1 1 −1 −1 1 1 −1 1 −1 1 −1 1 1 −1 1 −1 −1 −1 1 −1 −1 −1 1 −1 1 1 −1 −1 1 1 |
| | −1 −1 −1 −1 1 −1 1 1 −1 −1 1 −1 −1 −1 1 −1 1 1 −1 −1 −1 −1 −1 −1 −1 −1 −1 −1 |
| | 1 1 −1 1 −1 −1 1 −1 −1 1 1 −1 −1 1 1 1 −1 1 −1 −1 −1 1 −1 −1 −1 −1 −1 −1 1 −1 |
| | −1 −1 −1 −1 −1 −1 1 1 1 −1 −1 1 −1 −1 1 1 1 1 −1 −1 −1 1 −1 −1 1 −1 −1 1 1 1 −1 |
| | 1 1 −1 −1 −1 1 1 1 1 1 −1 −1 1 −1 −1 −1 −1 1 −1 −1 1 1 1 −1 1 −1 1 1 1 1 1 −1 1 |
| | −1 −1 −1 −1 1 1 −1 −1 1 1 1 1 1 1 1 1 1 1 1 −1 1 −1 1 1 1 −1 −1 1 1 1 −1 1 −1 −1 |
| | −1 −1 1 −1 −1 −1 −1 1 1 −1 −1 −1 1 1 −1 1 1 −1 −1 −1 1 1 1 1 −1 1 −1 1 −1 −1 1 |
| | −1 1 −1 −1 −1 −1 1 1 1 1 −1 1 −1 1 −1 1 −1 −1 1 −1 −1 1 −1 1 1 1 −1 1 1 1 1 1 −1 |
| | −1 1 1 1 1 −1 −1 −1 1 1 −1 −1 −1 −1 1 −1 −1 −1 1 1 1 −1 1 −1 −1 −1 1 −1 1 1 −1 |
| | −1 −1 1 1 −1 −1 −1 −1 1 1 1 −1 1 1 1 1 1 −1 −1 −1 −1 1 1 −1 −1 1 1 1 −1 −1 1 1 1 |
| | 1 −1 1 −1 1 −1 −1 −1 1 1 −1 −1 −1 1 1 1 1 1 1 −1 −1 −1 −1 −1 1 −1 −1 −1 1 −1 1 |
| | 1 −1 1 −1 1 −1 −1 −1 1 1 −1 1 1 1 1 1 1 −1 1 −1 −1 −1 1 1 1 1 −1 1 −1 −1 −1 1 1 |
| | −1 1 1 1 −1 −1 1 −1 1 −1 1 −1 1 1 1 −1 1 1 1 −1 1 −1 1 1 1 −1 −1 1 −1 −1 −1 1 −1 |
| | −1 1 −1 1 −1 −1 1 1 1 −1 −1 1 1 1 −1 −1 −1 −1 1 −1 1 1 1 1 −1 1 −1 −1 −1 −1 −1 |
| | 1 −1 1 1 1 −1 −1 −1 1 1 −1 1 1 1 1 1 −1 1 1 −1 −1 −1 −1 1 1 1 −1 −1 1 −1 1 1 −1 1 |
| | 1 −1 1 1 1 −1 −1 −1 −1 1 −1 −1 −1 −1 −1 −1 1 1 −1 1 −1 −1 −1 1 −1 1 1 −1 1 1 1 |
| | 1 −1 −1 1 −1 1 1 1 1 −1 1 −1 1 −1 1 −1 1 −1 −1 −1 1 −1 −1 1 1 −1 1 −1 −1 1 −1 |
| | −1 1 −1 1 −1 1 1 1 1 1 −1 −1 −1 −1 1 −1 1 −1 1 1 1 1 −1 1 1 1 −1 1 1 1 1 1 1 −1 |
| | −1 1 1 1 1 1 −1 1 1 1 −1 1 1 −1 1 −1 1 −1 −1 −1 −1 1 1 1 1 1 −1 −1 1 −1 1 1 −1 1 |
| | −1 −1 −1 1 1 −1 1 1 −1 1 −1 1 −1 1 1 1 −1 1 1 −1 1 1 −1 1 1 −1 −1 −1 1 −1 1 1 1 1 |
| | −1 −1 1 1 1 −1 −1 −1 −1 −1 1 1 1 1 1 1 1 −1 −1 −1 1 1 1 1 1 −1 −1 −1 1 −1 −1 −1 |
| | 1 1 −1 1 1 1 1 −1 −1 −1 1 −1 −1 1 1 1 1 1 −1 −1 1 −1 −1 −1 −1 −1 1 −1 1 1 1 1 1 |
| | −1 1 1 −1 −1 1 1 1 1 1 −1 1 1 −1 1 1 1 −1 1 1 1 −1 −1 −1 1 −1 1 −1 1 −1 1 −1 −1 |
| | −1 −1 −1 1 1 1 −1 −1 1 −1 1 −1 1 1 1 −1 1 −1 1 −1 −1 −1 1 −1 −1 1 −1 1 1 −1 −1 |
| | 1 1 −1 1 −1 1 1 −1 1 −1 1 −1 1 −1 1 −1 −1 1 −1 −1 −1 1 1 1 1 −1 −1 1 1 1 1 1 1 1 |
| | −1 1 −1 1 −1 1 1 −1 1 1 −1 1 1 −1 −1 1 −1 −1 1 1 1 −1 −1 −1 1 1 −1 1 −1 1 −1 1 |
| | −1 1 −1 1 −1 −1 −1 −1 1 −1 1 1 −1 −1 −1 −1 1 −1 1 −1 −1 −1 −1 −1 −1 1 −1 1 1 1 |
| | 1 −1 −1 −1 1 −1 −1 −1 −1 1 1 1 1 1 −1 1 −1 −1 1 1 −1 −1 −1 −1 −1 1 −1 1 1 −1 −1 |
| | −1 1 1 1 1 −1 −1 1 1 −1 −1 1 1 1 −1 −1 −1 1 −1 1 −1 1 1 −1 −1 −1 −1 −1 1 1 1 1 |
| | −1 1 −1 −1 −1 −1 −1 −1 1 1 1 1 −1 1 −1 1 1 −1 −1 −1 1 −1 1 1 −1 1 1 −1 1 1 −1 1 |
| | −1 −1 −1 1 1 −1 −1 −1 −1 1 −1 1 1 1 1 1 −1 −1 −1 −1 −1 1 1 −1 1 1 −1 1 −1 1 1 |
| | −1 1 1 −1 1 −1 −1 1 1 −1 −1 −1 −1 1 −1 −1 1 1 −1 1 −1 1 1 1 −1 1 −1 −1 1 1 1 1 |
| | −1 1 1 1 1 1 1 1 −1 1 −1 1 1 −1 1 −1 1 1 1 1 1 −1 −1 −1 1 −1 −1 1 −1 1 −1 1 1 −1 |
| | 1 −1 −1 −1 −1 1 −1 −1 1 −1 −1 1 −1 −1 1 −1 1 −1 1 −1 −1 1 1 −1 −1 1 −1 1 −1 1 1 |
| | −1 1 −1 1 1 −1 1 −1 −1 −1 −1 −1 1 −1 1 −1 −1 −1 −1 −1 1 −1 −1 1 1 1 −1 −1 −1 |
| | −1 1 1 1 −1 1 1 −1 −1 1 −1 −1 −1 1 1 1 −1 −1 −1 −1 1 1 −1 −1 −1 1 −1 −1 −1 1 −1 |
| | −1 1 −1 1 1 1 1 1 1 −1 1 1 1 1 −1 1 1 −1 −1 −1 −1 −1 1 −1 −1 −1 1 1 −1 1 −1 1 −1 |
| | −1 −1 −1 −1 1 −1 1 1 −1 1 −1 −1 1 1 1 1 1 1 1 −1 1 1 −1 −1 1 1 −1 −1 1 −1 1 1 1 1 |
| | 1 1 −1 −1 −1 1 1 −1 1 −1 −1 −1 −1 −1 1 −1 −1 1 −1 −1 −1 −1 −1 −1 −1 1 1 −1 1 |
| | −1 1 −1 −1 −1 1 1 1 −1 1 1 1 1 −1 −1 1 −1 −1 1 −1 1 −1 1 1 −1 −1 1 −1 −1 −1 1 1 |
| | −1 1 −1 −1 −1 1 −1 −1 −1 −1 1 1 1 −1 −1 −1 1 −1 −1 −1 1 −1 −1 −1 1 1 1 1 1 −1 1 |
| | −1 1 1 −1 −1 −1 −1 1 1 1 −1 1 −1 −1 1 1 −1 −1 1 −1 1 1 −1 1 −1 1 −1 −1 1 −1 1 |
| | −1 1 1 −1 1 1 1 −1 −1 1 −1 1 1 −1 −1 1 1 1 1 1 1 1 −1 −1 1 1 −1 1 1 1 1 1 −1 1 −1 |
| | 1 −1 −1 −1 1 −1 1 −1 −1 1 1 −1 1 1 1 −1 1 1 −1 1 1 1 1 −1 −1 −1 −1 −1 1 1 1 1 −1 |
| | −1 1 −1 −1 −1 −1 1 1 1 1 1 1 −1 −1 −1 1 1 1 −1 −1 −1 −1 −1 1 1 −1 −1 1 1 1 −1 1 |
| | −1 1 1 1 −1 −1 −1 1 −1 −1 1 −1 1 1 −1 1 −1 1 −1 1 −1 −1 1 −1 1 −1 −1 1 1 1 1 1 1 |
| | 1 1 −1 1 −1 −1 1 −1 −1 −1 1 −1 −1 −1 1 −1 1 −1 1 −1 1 1 −1 1 −1 −1 1 −1 −1 −1 |
| | −1 1 1 1 1 −1 −1 −1 −1 −1 1 −1 1 −1 −1 −1 1 1 1 −1 −1 1 −1 1 −1 −1 −1 1 −1 1 −1 |
| | −1 −1 −1 −1 1 1 1 1 1 1 −1 1 −1 −1 1 1 −1 1 1 −1 −1 1 −1 −1 1 −1 −1 −1 −1 −1 1 |
| | −1 −1 1 −1 1 1 −1 −1 −1 −1 −1 1 −1 1 −1 −1 1 −1 1 1 −1 −1 −1 −1 1 −1 −1 1 −1 |
| | −1 −1 −1 1 1 −1 1 1 −1 −1 −1 1 −1 −1 1 −1 1 −1 −1 −1 −1 1 −1 −1 1 −1 1 −1 −1 |
| | −1 1 −1 −1 −1 1 −1 −1 −1 −1 −1 1 1 1 −1 −1 −1 1 1 −1 1 1 −1 −1 1 −1 1 1 1 −1 −1 |
| | −1 1 −1 −1 −1 1 1 1 −1 1 1 1 −1 1 −1 1 −1 −1 −1 −1 1 −1 1 −1 1 −1 −1 −1 1 1 1 |
| | −1 −1 −1 1 1 −1 −1 −1 −1 −1 1 −1 −1 1 1 −1 −1 1 −1 −1 1 −1 −1 −1 1 1 1 −1 −1 1 |
| | 1 1 1 −1 −1 1 1 −1 −1 −1 −1 1 −1 −1 −1 −1 −1 1 −1 1 −1 1 −1 1 −1 1 −1 1 −1 1 1 |
| | −1 1 −1 1 −1 −1 −1 −1 −1 −1 1 1 1 −1 1 1 −1 1 1 1 −1 −1 1 −1 −1 −1 −1 −1 1 1 −1 |
| | 1 1 1 1 1 1 1 −1 −1 −1 −1 1 −1 1 1 −1 1 1 1 −1 −1 1 1 −1 1 −1 −1 1 −1 1 1 1 1 −1 |
| | 1 −1 −1 1 1 −1 1 −1 1 −1 1 −1 −1 −1 −1 −1 −1 −1 1 −1 −1 1 1 1 −1 1 1 −1 1 1 1 1 |
| | 1 1 −1 −1 −1 1 −1 1 1 −1 −1 −1 1 −1 1 −1 −1 −1 1 −1 1 −1 1 1 −1 −1 1 1 −1 1 1 1 |
| | −1 −1 1 −1 −1 1 1 −1 1 1 −1 −1 1 1 1 1 −1 −1 −1 1 −1 1 −1 −1 −1 1 1 −1 −1 1 1 |
| | −1 1 1 1 −1 1 −1 −1 −1 1 1 1 1 1 −1 −1 −1 −1 1 −1 −1 1 1 1 1 1 1 1 1 1 −1 −1 −1 1 |
| | −1 1 −1 1 −1 −1 1 −1 −1 −1 −1 −1 1 1 −1 −1 −1 1 1 1 1 −1 −1 −1 −1 −1 −1 1 1 −1 |
| | −1 −1 −1 1 1 −1 −1 −1 1 1 1 −1 1 −1 −1 −1 −1 1 1 1 −1 −1 1 1 1 −1 −1 1 1 1 −1 1 |
| | 1 −1 1 −1 1 −1 1 1 −1 1 1 1 −1 1 −1 −1 1 1 −1 1 1 1 1 1 −1 −1 1 1 −1 −1 −1 −1 −1 |
| | 1 −1 −1 −1 −1 −1 −1 1 −1 1 1 −1 −1 −1 −1 −1 1 1 −1 −1 −1 1 −1 −1 1 −1 −1 −1 1 |
| | −1 −1 1 1 1 1 −1 1 1 −1 1 −1 1 1 −1 −1 1 1 1 −1 −1 −1 −1 −1 −1 −1 1 1 1 1 −1 −1 |
| | −1 −1 1 −1 −1 1 −1 −1 1 1 1 1 −1 1 −1 −1 −1 −1 1 1 1 1 1 1 1 1 −1 1 1 1 1 −1 −1 |
| | −1 −1 −1 −1 −1 1 1 −1 −1 −1 −1 −1 −1 −1 −1 −1 1 −1 1 −1 1 −1 1 1 −1 −1 1 −1 1 |
| | −1 −1 1 −1 1 1 1 −1 1 −1 1 −1 1 −1 −1 −1 −1 1 1 −1 1 −1 −1 −1 1 1 −1 1 −1 1 1 |
| | −1 1 −1 −1 1 1 −1 1 −1 1 1 −1 −1 −1 −1 −1 1 −1 −1 1 −1 1 −1 1 −1 −1 −1 −1 −1 |
| | −1 1 −1 −1 −1 1 1 −1 −1 1 1 −1 −1 −1 1 −1 1 −1 1 −1 1 1 1 −1 −1 −1 1 −1 1 −1 −1 |
| | 1 1 −1 −1 −1 1 −1 1 1 1 1 1 1 1 1 1 −1 1 −1 −1 −1 1 −1 −1 1 −1 1 −1 1 −1 1 1 −1 |
| | −1 −1 1 1 −1 −1 1 1 1 1 1 −1 −1 1 1 1 1 1 1 −1 1 1 −1 1 −1 −1 1 −1 1 1 1 −1 1 1 |
| | −1 −1 1 −1 −1 1 −1 1 1 −1 −1 1 −1 1 1 −1 1 1 1 1 −1 1 −1 −1 1 1 1 −1 −1 1 −1 1 1 |
| | −1 −1 −1 −1 1 1 1 1 −1 −1 −1 1 1 1 −1 1 −1 1 −1 1 1 1 1 1 1 1 1 1 1 −1 −1 −1 −1 1 |
| | 1 −1 1 −1 1 1 −1 −1 −1 1 1 1 −1 −1 1 1 1 −1 1 −1 1 1 −1 1 −1 −1 1 −1 1 1 −1 1 1 1 |
| | −1 −1 −1 −1 −1 1 −1 −1 −1 −1 1 1 1 −1 1 1 1 −1 −1 −1 −1 −1 −1 −1 1 −1 −1 1 −1 |
| | −1 −1 1 1 −1 −1 1 1 1 1 −1 1 −1 1 1 1 −1 1 1 −1 1 −1 1 1 1 −1 −1 1 1 −1 1 1 −1 −1 |
| | −1 1 1 −1 −1 −1 1 −1 1 1 −1 1 −1 1 1 1 −1 1 −1 −1 1 1 1 1 −1 1 1 1 −1 1 −1 1 −1 |
| | 1 1 −1 1 −1 1 1 1 −1 −1 −1 −1 −1 1 1 −1 1 −1 1 1 −1 1 1 1 1 1 −1 1 1 1 1 −1 −1 1 |
| | 1 −1 −1 −1 1 −1 −1 −1 −1 −1 1 1 −1 1 −1 −1 1 1 1 1 1 −1 −1 −1 1 1 −1 1 1 1 −1 |
| | −1 −1 1 1 −1 1 −1 −1 1 1 −1 1 −1 −1 −1 −1 −1 −1 −1 1 1 −1 −1 1 1 −1 −1 −1 −1 1 |
| | 1 −1 1 −1 −1 1 1 −1 −1 1 −1 −1 −1 −1 1 −1 1 1 −1 1 −1 1 1 −1 1 1 1 −1 −1 −1 1 1 |
| | 1 −1 −1 −1 1 1 1 1 −1 −1 −1 1 1 −1 1 1 −1 1 −1 −1 1 1 1 1 −1 −1 1 −1 1 1 1 −1 1 1 |
| | −1 1 −1 −1 −1 1 −1 −1 1 −1 −1 1 1 −1 1 1 1 −1 −1 1 1 1 1 1 −1 1 −1 −1 −1 1 1 −1 |
| | −1 −1 1 −1 −1 1 1 1 −1 1 −1 −1 −1 1 1 1 −1 −1 −1 −1 −1 −1 −1 −1 −1 1 1 −1 −1 1 |
| | −1 1 −1 −1 −1 1 −1 −1 1 −1 −1 −1 −1 −1 1 1 1 1 −1 1 1 1 −1 −1 −1 −1 −1 1 1 1 −1 |
| | −1 1 1 −1 −1 1 1 1 1 1 −1 1 −1 1 1 1 1 −1 −1 1 1 −1 −1 1 −1 −1 −1 −1 −1 1 1 1 −1 |
| | 1 1 1 1 −1 1 −1 −1 −1 1 −1 −1 −1 1 1 −1 1 −1 −1 1 −1 −1 −1 −1 −1 −1 1 1 −1 −1 1 |
| | −1 −1 1 −1 −1 1 −1 1 1 −1 −1 −1 1 1 1 −1 1 −1 1 1 −1 1 1 1 1 −1 1 1 1 1 1 1 −1 1 |
| | 1 −1 1 1 1 1 −1 1 −1 −1 1 1 −1 1 −1 −1 1 1 1 −1 1 1 −1 −1 1 −1 1 1 1 1 1 −1 1 |
| | −1 −1 1 1 1 1 −1 −1 −1 1 1 1 1 −1 −1 1 −1 1 −1 1 1 1 1 −1 −1 1 −1 −1 1 1 −1 −1 1 |
| | 1 −1 1 1 −1 −1 −1 −1 −1 −1 −1 −1 1 1 1 1 −1 1 1 −1 1 −1 −1 −1 −1 −1 1 1 −1 −1 |
| | −1 −1 −1 1 1 −1 −1 1 −1 −1 −1 1 −1 1 −1 1 −1 −1 −1 −1 1 −1 −1 −1 −1 −1 −1 −1 |
| | −1 −1 1 −1 −1 1 1 −1 1 1 1 −1 1 −1 1 1 1 1 1 1 −1 −1 −1 −1 −1 −1 1 −1 −1 1 −1 |
| | −1 1 −1 1 −1 −1 1 −1 1 1 −1 1 1 −1 1 −1 −1 −1 −1 −1 −1 −1 −1 −1 −1 −1 1 1 1 −1 |
| | −1 −1 1 −1 1 1 1 −1 −1 −1 −1 1 1 1 1 1 −1 −1 −1 1 1 1 −1 1 1 −1 −1 1 1 1 −1 1 1 1 |
| | 1 −1 −1 −1 1 −1 1 −1 1 1 1 1 −1 −1 −1 1 −1 1 1 −1 1 1 1 −1 1 −1 1 −1 1 −1 1 1 −1 |
| | 1 1 −1 −1 −1 −1 −1 1 −1 1 1 1 1 −1 1 1 1 −1 −1 −1 1 1 1 1 1 −1 1 1 1 −1 −1 −1 −1 |
| | 1 −1 1 1 −1 −1 −1 1 −1 −1 1 −1 −1 1 −1 −1 −1 1 1 −1 1 −1 1 1 1 −1 −1 −1 1 1 1 1 |
| | −1 1 1 1 1 −1 1 −1 −1 1 −1 −1 −1 −1 1 −1 −1 1 −1 −1 −1 1 −1 1 −1 1 1 1 −1 −1 1 |
| | −1 1 −1 −1 −1 −1 1 −1 −1 −1 1 −1 1 1 1 −1 −1 1 1 1 1 1 1 −1 −1 −1 −1 1 −1 −1 |
| | −1 −1 1 1 1 1 −1 1 1 −1 −1 1 −1 −1 −1 −1 −1 1 −1 −1 −1 1 1 1 −1 −1 1 −1 −1 1 −1 |
| | −1 1 −1 −1 −1 −1 −1 −1 1 −1 1 −1 1 −1 −1 −1 −1 −1 1 −1 −1 −1 −1 1 −1 −1 −1 1 |
| | 1 1 1 −1 −1 −1 −1 1 1 1 1 −1 −1 1 −1 1 1 −1 1 1 1 −1 1 1 −1 −1 1 −1 1 −1 −1 1 1 |
| | −1 1 1 −1 1 1 1 −1 1 −1 1 1 −1 −1 1 1 −1 −1 1 −1 −1 −1 1 1 1 1 1 −1 −1 1 1 1 −1 |
| | −1 1 −1 1 1 1 1 −1 −1 1 1 −1 1 −1 −1 −1 −1 −1 1 1 1 1 −1 −1 −1 1 −1 −1 −1 1 −1 |
| | 1 1 1 1 1 1 −1 −1 1 −1 1 −1 1 −1 1 −1 −1 −1 1 1 1 1 1 −1 1 1 −1 1 −1 −1 −1 1 1 1 |
| | 1 −1 −1 1 −1 −1 1 1 1 1 1 1 −1 1 −1 −1 −1 −1 −1 1 1 −1 1 1 −1 −1 1 1 1 −1 1 −1 |
| | −1 1 −1 −1 −1 −1 −1 1 −1 1 −1 −1 1 1 −1 1 −1 −1 −1 1 1 −1 −1 1 1 1 −1 1 1 −1 1 |
| | 1 −1 −1 1 1 −1 −1 1 1 −1 1 1 1 1 −1 −1 −1 −1 1 −1 1 1 1 −1 1 1 −1 −1 −1 1 −1 1 |
| | −1 1 −1 −1 −1 1 −1 −1 −1 −1 −1 1 −1 −1 −1 −1 −1 1 −1 −1 1 1 −1 1 −1 −1 −1 1 |
| | −1 1 −1 1 1 1 1 1 1 −1 1 −1 1 −1 −1 1 1 1 1 −1 −1 −1 −1 −1 1 1 −1 −1 −1 −1 1 −1 |
| | 1 −1 −1 1 1 −1 −1 1 −1 −1 1 1 1 −1 1 1 1 1 −1 1 1 1 −1 1 −1 −1 1 1 1 −1 1 1 1 1 1 |
| | −1 1 1 −1 1 1 −1 1 1 1 1 −1 1 −1 1 −1 1 1 −1 −1 −1 −1 1 1 −1 1 1 −1 −1 1 −1 −1 |
| | −1 1 −1 −1 −1 −1 −1 −1 −1 1 −1 −1 −1 −1 1 −1 1 1 1 1 1 1 1 −1 −1 −1 1 −1 −1 1 1 |
| | −1 −1 1 1 −1 −1 −1 −1 −1 −1 −1 1 −1 −1 −1 1 −1 −1 1 1 1 −1 1 1 1 −1 1 1 1 1 −1 |
| | −1 −1 −1 1 1 −1 1 1 −1 1 −1 −1 −1 −1 1 1 −1 −1 −1 −1 1 1 1 1 −1 1 1 1 1 1 −1 −1 |
| | −1 1 −1 1 −1 −1 1 −1 1 −1 −1 1 −1 −1 1 1 1 1 −1 −1 1 −1 −1 −1 1 −1 1 1 1 1 −1 |
| | −1 −1 −1 1 −1 −1 −1 1 −1 1 1 1 −1 −1 1 −1 −1 1 1 1 −1 1 −1 −1 1 −1 1 1 −1 −1 1 |
| | −1 −1 −1 −1 1 1 1 −1 −1 1 −1 −1 −1 −1 1 1 −1 −1 1 1 −1 −1 1 1 1 1 −1 1 1 −1 1 1 |
| | −1 1 −1 −1 1 −1 1 −1 −1 −1 1 1 −1 1 1 −1 −1 1 1 −1 1 1 −1 −1 1 1 −1 −1 −1 −1 −1 |
| | 1 1 1 −1 −1 −1 −1 −1 −1 1 1 −1 1 1 −1 1 1 −1 1 −1 1 1 1 1 −1 −1 1 −1 1 −1 1 −1 |
| | −1 1 −1 −1 1 1 −1 1 1 −1 1 −1 1 1 1 −1 1 −1 1 −1 1 1 1 −1 −1 1 1 1 1 |
| 4 | −1 −1 −1 −1 −1 −1 −1 −1 −1 −1 −1 −1 −1 1 −1 −1 −1 1 1 −1 1 −1 −1 −1 −1 1 −1 1 |
| | −1 1 1 1 1 1 −1 −1 1 1 −1 −1 1 1 1 −1 1 1 1 −1 1 1 −1 −1 −1 1 1 −1 −1 1 1 −1 −1 |
| | −1 1 1 −1 −1 1 1 1 1 −1 1 −1 −1 1 −1 −1 1 1 −1 −1 1 1 −1 1 −1 1 1 −1 1 1 −1 −1 |
| | −1 −1 −1 1 −1 −1 −1 −1 −1 1 1 −1 −1 −1 −1 1 −1 1 1 −1 −1 1 −1 −1 −1 −1 −1 1 1 |
| | −1 1 −1 1 1 1 −1 −1 −1 −1 −1 −1 −1 1 −1 −1 1 1 1 1 −1 1 −1 −1 1 1 1 1 1 1 −1 −1 |
| | −1 1 1 −1 1 −1 1 −1 −1 1 −1 −1 −1 −1 −1 −1 1 −1 1 −1 −1 1 −1 1 1 −1 1 1 −1 1 1 |
| | −1 1 1 −1 1 −1 1 1 −1 −1 1 1 1 −1 1 1 −1 −1 −1 1 1 1 1 1 1 1 −1 1 −1 −1 −1 1 |
| | −1 −1 −1 1 −1 −1 −1 1 −1 1 1 −1 −1 1 1 −1 −1 1 1 −1 1 −1 −1 −1 −1 1 −1 −1 1 1 1 |
| | −1 1 −1 1 1 1 1 −1 1 −1 −1 −1 1 1 1 1 −1 −1 1 1 −1 1 1 −1 −1 −1 −1 −1 −1 −1 1 |
| | −1 1 1 −1 1 −1 1 −1 −1 −1 −1 1 1 −1 1 1 −1 −1 1 1 1 −1 −1 1 −1 1 1 −1 1 1 −1 1 |
| | −1 1 1 1 1 1 1 −1 −1 −1 −1 1 −1 −1 1 −1 −1 −1 −1 −1 1 −1 1 −1 1 −1 1 1 1 −1 1 1 |
| | −1 1 1 1 −1 −1 −1 −1 1 1 1 1 −1 −1 1 1 1 1 −1 −1 1 1 1 −1 −1 1 1 −1 −1 1 −1 1 −1 |
| | −1 −1 −1 −1 1 −1 −1 1 −1 −1 1 1 1 −1 1 1 −1 −1 −1 −1 −1 1 1 −1 1 −1 1 −1 −1 −1 |
| | −1 1 −1 1 1 1 1 −1 −1 −1 −1 −1 −1 1 1 −1 −1 1 −1 1 −1 1 −1 −1 1 −1 1 −1 1 1 −1 |
| | −1 1 −1 −1 −1 −1 1 −1 1 −1 −1 −1 −1 −1 −1 −1 −1 −1 1 1 1 1 −1 −1 −1 1 1 −1 1 1 |
| | 1 1 −1 −1 1 1 −1 −1 1 −1 1 1 1 −1 −1 1 1 1 1 −1 −1 −1 1 −1 −1 1 −1 −1 −1 −1 −1 |
| | −1 1 1 −1 −1 −1 −1 −1 −1 −1 1 1 1 −1 −1 −1 1 −1 −1 −1 1 −1 1 −1 −1 1 1 −1 1 1 1 |
| | 1 1 1 −1 1 −1 −1 1 −1 1 1 1 1 1 −1 1 −1 −1 −1 −1 1 1 1 −1 1 1 −1 1 −1 1 1 1 −1 1 |
| | −1 −1 1 1 1 1 −1 1 1 −1 1 −1 −1 −1 1 1 1 −1 1 1 −1 −1 −1 1 −1 −1 1 1 −1 1 1 −1 1 |
| | −1 −1 −1 −1 1 1 1 −1 −1 −1 −1 1 1 1 −1 −1 1 1 −1 −1 −1 −1 −1 −1 1 1 1 −1 1 1 −1 |
| | 1 1 −1 1 1 1 1 1 1 −1 1 1 1 1 −1 −1 1 −1 −1 −1 −1 1 −1 1 1 1 −1 −1 1 −1 1 1 1 1 1 |
| | 1 −1 1 1 1 −1 1 −1 1 1 −1 1 1 −1 −1 1 1 −1 1 1 −1 1 1 1 1 1 −1 1 1 1 −1 1 1 1 −1 |
| | −1 −1 −1 1 −1 1 −1 −1 1 −1 −1 1 1 1 −1 1 −1 1 −1 −1 1 −1 −1 −1 1 1 −1 1 1 1 1 1 |
| | −1 −1 1 1 1 −1 −1 1 −1 1 −1 1 1 1 1 1 1 −1 −1 1 1 1 −1 1 1 1 1 1 −1 −1 1 1 −1 1 |
| | −1 1 1 1 1 −1 −1 1 1 1 −1 1 1 −1 −1 1 −1 1 1 −1 1 −1 −1 1 1 −1 −1 1 1 −1 1 1 −1 1 |
| | −1 −1 1 1 1 1 −1 −1 1 1 1 1 1 1 1 1 −1 −1 1 −1 −1 −1 −1 1 1 −1 1 1 1 −1 −1 1 −1 1 |
| | 1 1 −1 −1 1 −1 −1 1 −1 1 −1 −1 1 1 1 −1 −1 1 1 1 1 −1 1 −1 −1 −1 1 −1 1 −1 −1 1 |
| | −1 −1 −1 1 −1 −1 −1 1 −1 −1 −1 −1 −1 −1 1 1 1 −1 1 −1 1 1 1 1 1 −1 −1 −1 1 1 −1 |
| | −1 −1 −1 −1 1 −1 1 −1 −1 1 −1 −1 −1 −1 1 −1 −1 −1 −1 1 1 1 −1 −1 1 −1 −1 1 −1 |
| | 1 1 1 1 1 −1 −1 1 −1 −1 1 1 −1 −1 1 1 1 −1 −1 1 −1 −1 −1 −1 1 −1 −1 −1 1 −1 1 1 |
| | 1 −1 −1 1 1 1 −1 1 −1 −1 −1 −1 1 −1 1 −1 −1 −1 1 1 −1 −1 1 −1 −1 −1 −1 1 −1 −1 |
| | 1 −1 −1 1 −1 1 1 1 −1 1 1 −1 −1 1 1 1 1 1 −1 1 −1 1 −1 −1 1 1 −1 −1 −1 −1 1 1 1 |
| | −1 1 −1 −1 1 1 −1 −1 1 −1 −1 −1 1 1 −1 1 −1 1 −1 1 1 1 −1 1 1 1 −1 1 1 1 −1 1 1 |
| | −1 1 1 1 1 1 −1 −1 −1 1 −1 −1 1 −1 1 1 −1 −1 1 1 −1 1 1 −1 −1 −1 1 1 −1 −1 −1 |
| | −1 −1 −1 1 1 −1 1 1 1 1 1 −1 1 −1 1 1 1 −1 −1 1 −1 −1 1 1 −1 −1 −1 −1 1 −1 1 1 1 |
| | 1 1 −1 1 −1 1 1 −1 1 −1 1 1 −1 −1 −1 1 −1 −1 −1 −1 1 −1 −1 −1 1 1 −1 1 1 1 −1 |
| | −1 −1 −1 −1 1 −1 1 1 1 −1 1 1 −1 −1 −1 −1 1 1 −1 −1 −1 1 −1 −1 −1 1 −1 1 1 1 1 |
| | 1 1 1 −1 −1 −1 1 1 −1 −1 1 1 −1 1 1 1 1 1 −1 −1 −1 −1 1 −1 1 1 1 −1 1 1 1 1 −1 −1 |
| | −1 1 1 1 1 1 −1 −1 1 −1 1 −1 −1 1 1 1 1 −1 −1 1 −1 −1 1 1 −1 1 −1 1 1 1 −1 −1 1 1 |
| | −1 −1 1 1 1 1 −1 1 1 1 1 −1 1 1 −1 1 1 1 1 −1 −1 1 −1 −1 1 1 1 −1 −1 1 −1 1 1 1 |
| | −1 1 −1 −1 −1 −1 −1 −1 1 1 1 1 1 1 1 −1 −1 −1 1 −1 1 −1 1 −1 −1 −1 −1 −1 1 1 −1 |
| | 1 1 1 −1 1 1 1 1 −1 −1 1 −1 1 1 −1 1 1 1 −1 −1 1 −1 1 −1 −1 −1 −1 −1 −1 1 −1 1 1 |
| | −1 −1 −1 −1 −1 1 1 1 1 1 1 1 1 1 −1 1 1 1 1 −1 1 −1 −1 −1 1 −1 −1 1 −1 1 1 −1 1 |
| | −1 1 −1 −1 1 1 1 1 1 1 −1 1 1 1 1 1 1 1 −1 1 −1 1 −1 1 1 1 1 1 1 −1 1 −1 1 1 1 1 −1 |
| | −1 −1 1 −1 −1 −1 −1 1 −1 1 1 1 1 1 1 −1 −1 1 −1 −1 −1 1 −1 1 −1 −1 1 −1 1 1 1 |
| | −1 1 −1 −1 1 1 −1 −1 −1 1 −1 −1 −1 1 1 −1 1 1 −1 1 −1 −1 1 −1 −1 1 −1 1 1 −1 −1 |
| | −1 1 1 1 −1 1 1 −1 1 −1 −1 −1 1 −1 −1 −1 1 −1 −1 1 1 −1 −1 −1 1 −1 1 −1 −1 1 1 |
| | −1 −1 −1 1 1 −1 1 1 −1 1 −1 1 −1 −1 −1 −1 −1 −1 −1 1 −1 −1 1 −1 −1 1 −1 −1 −1 |
| | 1 −1 −1 1 1 1 −1 1 1 1 −1 1 −1 1 −1 −1 −1 1 1 1 −1 1 −1 −1 1 −1 −1 1 1 1 1 1 1 1 |
| | 1 1 −1 −1 −1 1 1 1 1 1 1 1 1 −1 −1 −1 1 −1 −1 1 1 −1 1 −1 1 1 −1 1 −1 1 −1 −1 1 |
| | −1 −1 1 1 −1 −1 −1 −1 −1 1 1 1 −1 1 −1 1 −1 −1 1 1 1 −1 1 −1 −1 −1 −1 −1 1 1 −1 |
| | 1 −1 −1 −1 1 −1 1 −1 1 1 1 −1 1 −1 1 −1 −1 −1 −1 −1 1 −1 −1 −1 1 −1 1 −1 1 1 −1 |
| | −1 −1 −1 −1 1 1 −1 −1 1 1 −1 1 −1 1 −1 1 1 1 1 −1 1 1 1 1 −1 −1 1 1 1 −1 −1 −1 |
| | −1 −1 −1 −1 −1 −1 1 1 −1 −1 −1 −1 1 1 −1 1 −1 1 1 1 1 1 −1 −1 1 −1 1 −1 1 −1 1 |
| | 1 −1 −1 1 −1 1 −1 1 1 1 −1 1 −1 −1 1 −1 −1 1 −1 −1 1 1 −1 1 −1 −1 1 −1 −1 1 −1 |
| | −1 −1 −1 −1 1 1 −1 −1 1 1 1 −1 −1 1 1 1 −1 −1 −1 −1 1 1 −1 −1 1 1 −1 1 1 −1 −1 |
| | 1 −1 1 −1 1 −1 1 1 1 1 1 −1 −1 −1 −1 −1 −1 −1 1 −1 1 −1 1 1 −1 −1 −1 1 1 1 1 1 |
| | −1 −1 −1 1 1 −1 1 1 −1 −1 −1 −1 −1 1 1 1 −1 −1 1 1 −1 1 1 −1 −1 1 1 −1 −1 1 1 1 |
| | −1 −1 −1 1 −1 −1 1 1 1 1 1 1 −1 1 −1 −1 1 1 −1 1 1 −1 1 1 −1 1 −1 −1 −1 −1 −1 |
| | −1 1 −1 1 −1 1 −1 −1 1 −1 −1 −1 −1 1 1 1 −1 −1 −1 1 −1 1 1 1 −1 −1 −1 1 −1 −1 |
| | −1 1 1 −1 −1 −1 −1 1 1 −1 −1 1 1 1 −1 1 −1 1 1 1 −1 1 1 −1 1 −1 −1 −1 −1 1 −1 |
| | −1 −1 −1 1 −1 −1 −1 −1 −1 −1 1 −1 1 1 1 1 −1 −1 1 1 −1 −1 −1 1 1 1 −1 −1 1 −1 |
| | −1 1 1 −1 1 1 −1 1 1 1 −1 −1 −1 1 −1 1 1 −1 −1 1 −1 −1 1 1 −1 1 −1 −1 −1 1 −1 1 |
| | 1 −1 1 1 1 1 1 −1 1 −1 −1 −1 1 −1 1 1 1 1 −1 1 −1 −1 1 1 −1 1 −1 1 1 1 1 1 1 1 1 |
| | −1 −1 −1 −1 1 −1 1 −1 −1 −1 1 −1 1 −1 1 1 −1 1 1 −1 −1 −1 1 1 1 −1 1 −1 1 1 −1 |
| | 1 −1 −1 1 1 −1 1 −1 1 −1 −1 1 1 −1 1 −1 1 1 −1 −1 1 1 −1 1 1 1 1 −1 1 −1 −1 1 1 1 |
| | −1 −1 1 −1 1 −1 −1 −1 1 −1 1 1 1 −1 1 1 −1 −1 −1 −1 −1 −1 −1 −1 1 1 1 1 1 1 |
| | −1 1 −1 −1 −1 −1 −1 1 −1 −1 −1 −1 1 1 −1 −1 1 1 1 1 −1 −1 1 −1 1 1 −1 −1 −1 1 |
| | −1 1 1 1 −1 1 −1 −1 −1 1 1 −1 1 −1 1 −1 −1 −1 1 −1 −1 1 −1 1 −1 1 1 −1 −1 −1 1 |
| | −1 −1 1 1 1 −1 1 −1 −1 −1 1 1 1 1 1 1 1 1 1 1 −1 1 1 −1 −1 −1 1 1 −1 1 −1 1 −1 1 |
| | −1 −1 −1 1 −1 1 1 −1 −1 1 −1 1 −1 1 −1 −1 −1 1 1 −1 −1 1 1 1 −1 −1 −1 −1 1 −1 1 |
| | −1 1 −1 −1 −1 −1 1 −1 1 −1 −1 1 −1 1 −1 1 1 1 1 1 −1 1 −1 1 −1 1 1 −1 −1 1 1 1 1 |
| | 1 −1 −1 1 1 −1 1 1 −1 1 1 −1 −1 1 −1 −1 1 −1 1 −1 1 1 −1 1 1 1 −1 1 1 −1 −1 1 1 |
| | −1 −1 1 −1 −1 −1 −1 1 1 1 1 −1 1 1 1 −1 −1 1 −1 1 −1 1 1 −1 −1 1 1 1 −1 −1 −1 |
| | −1 −1 1 1 −1 −1 −1 1 1 1 1 −1 1 1 1 −1 1 −1 −1 1 1 1 −1 1 1 1 1 1 1 1 1 1 1 1 1 −1 |
| | −1 1 1 −1 1 −1 −1 −1 1 1 1 −1 −1 −1 −1 −1 1 1 1 1 −1 1 −1 1 −1 1 −1 1 1 −1 −1 1 |
| | 1 −1 −1 1 −1 1 1 −1 1 −1 1 −1 1 −1 1 1 −1 1 −1 1 −1 1 1 1 −1 −1 −1 1 −1 −1 1 −1 |
| | 1 −1 1 −1 1 −1 −1 −1 −1 1 −1 −1 1 −1 1 1 1 1 −1 −1 1 1 1 1 −1 1 −1 1 1 1 −1 −1 |
| | −1 1 −1 1 −1 −1 1 1 1 1 −1 1 −1 −1 −1 −1 1 1 −1 1 1 1 1 1 1 −1 −1 1 −1 1 1 1 −1 |
| | −1 −1 1 −1 1 1 1 1 1 −1 1 1 −1 1 −1 −1 −1 −1 −1 1 −1 −1 1 1 1 1 1 −1 −1 −1 −1 1 |
| | −1 −1 −1 1 −1 −1 1 −1 −1 1 −1 −1 1 −1 −1 −1 −1 1 −1 1 −1 1 1 −1 −1 1 −1 1 1 −1 |
| | 1 1 1 1 1 1 −1 −1 −1 1 1 1 −1 −1 1 1 −1 −1 1 1 −1 −1 −1 1 −1 1 −1 1 −1 1 −1 1 −1 |
| | −1 −1 1 1 1 −1 −1 1 −1 1 1 −1 −1 −1 −1 1 1 1 −1 −1 −1 1 1 −1 1 1 1 −1 1 −1 1 −1 |
| | −1 1 −1 1 1 1 1 1 1 −1 −1 −1 1 −1 −1 −1 −1 −1 1 1 1 −1 1 −1 −1 1 −1 1 −1 1 1 −1 |
| | 1 −1 −1 −1 1 −1 −1 1 −1 −1 −1 −1 1 1 1 1 1 −1 1 1 1 −1 −1 1 −1 −1 1 1 1 1 −1 −1 |
| | −1 −1 −1 −1 −1 1 1 −1 −1 1 −1 −1 1 1 −1 1 1 1 −1 1 1 1 −1 1 −1 1 1 1 −1 1 −1 1 1 |
| | −1 1 −1 1 −1 1 −1 −1 −1 −1 1 1 1 1 −1 −1 1 −1 −1 1 −1 1 1 −1 −1 1 −1 1 1 1 1 −1 |
| | 1 −1 −1 −1 −1 −1 1 1 1 −1 −1 −1 1 1 1 −1 1 1 1 1 1 −1 1 −1 1 −1 −1 −1 −1 −1 −1 |
| | 1 −1 −1 −1 −1 −1 1 −1 1 −1 −1 1 1 1 −1 −1 −1 −1 1 1 1 1 1 1 1 1 −1 1 1 1 −1 1 1 |
| | −1 1 −1 −1 1 1 1 −1 1 −1 1 −1 1 −1 −1 −1 1 1 −1 1 −1 1 1 1 −1 1 1 −1 −1 1 −1 −1 |
| | 1 1 1 1 1 −1 1 −1 1 1 1 1 1 1 −1 1 1 −1 1 1 −1 −1 1 1 −1 −1 −1 −1 1 −1 1 −1 −1 1 |
| | 1 1 1 1 −1 −1 −1 1 −1 −1 −1 1 1 1 1 −1 −1 −1 1 1 1 −1 1 1 −1 −1 1 −1 −1 −1 −1 1 |
| | 1 −1 −1 −1 1 −1 1 1 1 −1 −1 1 −1 −1 −1 1 1 −1 1 1 −1 −1 1 −1 1 1 −1 −1 1 −1 1 |
| | −1 −1 1 −1 −1 −1 1 1 1 −1 1 1 −1 1 1 1 −1 1 1 −1 1 −1 1 −1 1 1 1 1 1 −1 1 1 −1 −1 |
| | 1 −1 −1 1 −1 −1 1 1 1 1 1 −1 −1 1 1 1 −1 1 −1 −1 1 1 1 −1 −1 −1 1 1 −1 1 −1 −1 |
| | −1 1 1 1 1 1 −1 −1 1 1 −1 −1 −1 −1 1 −1 −1 1 −1 1 −1 1 −1 −1 1 −1 −1 1 1 1 1 −1 |
| | −1 1 1 −1 −1 1 1 −1 1 1 1 −1 −1 −1 −1 1 −1 −1 1 −1 1 1 −1 −1 −1 −1 −1 1 −1 −1 1 |
| | 1 −1 1 −1 −1 1 1 1 1 −1 1 −1 1 1 −1 1 −1 −1 −1 −1 −1 1 1 1 1 1 −1 1 −1 1 1 −1 −1 |
| | 1 1 1 1 −1 1 −1 1 −1 −1 −1 −1 1 1 1 −1 1 −1 1 1 −1 −1 1 −1 1 −1 −1 −1 1 −1 −1 |
| | −1 1 −1 1 −1 1 −1 1 −1 −1 1 −1 −1 −1 1 −1 1 1 1 −1 1 −1 1 1 1 1 1 1 1 −1 1 −1 −1 |
| | 1 1 1 −1 1 −1 −1 1 1 −1 1 −1 −1 −1 1 1 −1 1 −1 −1 1 −1 −1 −1 −1 1 −1 1 1 −1 1 |
| | −1 1 1 1 −1 −1 −1 1 1 −1 −1 −1 −1 1 −1 −1 1 1 −1 −1 1 1 −1 −1 1 1 1 1 1 −1 1 1 |
| | −1 −1 −1 −1 1 1 1 1 −1 1 1 −1 1 −1 1 1 1 1 −1 −1 −1 −1 1 −1 −1 1 1 1 −1 −1 1 1 1 |
| | −1 1 1 −1 1 −1 −1 1 −1 −1 −1 1 1 1 1 −1 1 −1 −1 1 −1 1 −1 1 −1 1 1 −1 1 −1 −1 1 |
| | 1 1 −1 −1 1 1 −1 −1 −1 1 1 −1 1 −1 1 1 −1 −1 −1 1 1 1 −1 −1 −1 −1 1 1 −1 1 −1 1 |
| | −1 −1 1 1 1 −1 −1 1 −1 −1 1 −1 −1 −1 1 1 −1 −1 1 −1 1 −1 1 1 1 1 −1 −1 −1 −1 −1 |
| | 1 −1 1 −1 1 1 1 −1 1 1 −1 −1 −1 1 −1 1 −1 1 −1 −1 1 1 −1 1 −1 −1 −1 −1 −1 −1 1 |
| | 1 −1 −1 1 1 −1 −1 1 1 −1 −1 1 −1 −1 1 1 1 1 −1 1 1 −1 −1 1 −1 −1 −1 1 −1 1 −1 1 |
| | −1 −1 1 −1 1 1 −1 1 −1 1 1 1 1 1 −1 1 −1 −1 1 1 1 1 −1 −1 −1 −1 1 1 −1 1 −1 −1 1 |
| | −1 1 −1 1 1 1 −1 −1 −1 1 1 1 1 −1 −1 −1 −1 1 −1 −1 −1 −1 1 −1 1 1 −1 −1 1 1 1 |
| | −1 −1 1 1 −1 1 −1 −1 1 1 −1 1 1 1 1 −1 −1 −1 1 1 −1 −1 1 −1 1 1 1 −1 1 −1 1 1 −1 |
| | −1 1 1 −1 −1 −1 1 1 1 1 1 1 −1 1 1 −1 1 −1 1 −1 1 −1 −1 1 1 1 1 −1 1 1 1 −1 −1 −1 |
| | 1 1 −1 −1 1 1 1 −1 1 1 −1 1 1 1 1 −1 1 −1 −1 −1 −1 1 −1 1 1 1 −1 1 −1 −1 1 −1 1 |
| | −1 −1 −1 −1 1 1 −1 1 −1 1 −1 1 −1 1 1 1 −1 −1 1 1 1 −1 −1 1 −1 −1 1 1 1 −1 1 −1 |
| | −1 1 −1 1 1 −1 1 −1 −1 −1 1 1 −1 −1 −1 1 1 1 1 1 −1 1 1 1 1 1 1 −1 1 1 −1 −1 −1 |
| | −1 −1 −1 1 1 1 1 −1 1 −1 −1 1 1 −1 −1 1 1 1 −1 1 −1 −1 −1 1 −1 −1 1 1 −1 1 −1 |
| | −1 −1 −1 1 1 1 1 1 −1 −1 −1 1 −1 1 1 1 1 −1 1 1 1 1 1 1 1 1 −1 −1 1 1 1 −1 −1 −1 |
| | 1 1 −1 −1 1 −1 −1 −1 1 −1 −1 −1 −1 −1 1 −1 1 1 1 1 1 −1 −1 1 1 1 1 1 1 −1 −1 −1 |
| | −1 −1 −1 1 1 1 1 1 −1 −1 −1 −1 1 1 1 −1 1 1 −1 −1 1 1 1 −1 −1 −1 1 1 1 1 1 −1 1 |
| | −1 −1 1 1 −1 −1 −1 −1 1 −1 −1 −1 1 1 −1 −1 −1 1 −1 1 −1 1 1 −1 −1 1 1 −1 1 −1 |
| | −1 1 −1 −1 −1 1 −1 −1 1 −1 −1 −1 1 −1 1 1 −1 1 1 −1 −1 1 −1 −1 −1 1 1 −1 −1 1 1 |
| | −1 −1 1 −1 1 −1 1 1 −1 −1 −1 −1 1 −1 1 −1 1 1 −1 1 −1 −1 1 −1 −1 −1 −1 −1 1 1 1 |
| | 1 1 1 −1 −1 1 −1 −1 1 −1 −1 1 1 −1 −1 1 −1 1 1 −1 −1 1 1 −1 −1 −1 −1 −1 1 1 −1 |
| | 1 1 −1 −1 −1 1 −1 −1 1 −1 1 1 1 1 1 1 1 1 −1 1 1 −1 1 1 1 1 1 1 1 −1 1 1 −1 −1 1 |
| | −1 1 −1 −1 −1 −1 1 −1 −1 −1 −1 −1 1 −1 −1 1 −1 1 −1 1 1 1 1 −1 1 1 −1 −1 −1 −1 |
| | −1 1 −1 1 1 −1 −1 −1 1 1 1 1 −1 1 −1 −1 −1 1 1 −1 −1 −1 −1 −1 1 1 −1 −1 −1 −1 |
| | −1 1 1 1 1 −1 −1 1 1 −1 −1 −1 −1 −1 1 −1 1 1 1 1 −1 1 −1 1 −1 1 −1 −1 −1 −1 −1 |
| | −1 1 1 1 −1 −1 1 1 1 −1 1 −1 1 1 −1 1 1 1 1 1 1 1 1 −1 1 −1 1 1 1 −1 1 −1 −1 −1 |
| | −1 1 1 1 1 −1 1 −1 −1 −1 −1 −1 −1 −1 1 −1 1 −1 −1 −1 −1 −1 1 1 −1 −1 −1 1 −1 |
| | −1 1 −1 −1 1 −1 1 −1 −1 −1 1 −1 −1 1 −1 −1 1 1 1 1 −1 1 −1 1 −1 1 1 −1 1 −1 1 1 |
| | −1 1 1 1 −1 1 −1 1 −1 1 −1 −1 1 −1 1 −1 −1 −1 −1 −1 −1 −1 1 1 1 1 −1 1 1 1 1 1 1 |
| | −1 −1 −1 −1 −1 1 −1 1 1 −1 1 1 1 1 −1 1 1 −1 1 −1 −1 1 −1 1 1 1 1 −1 1 1 −1 1 −1 |
| | 1 −1 −1 1 −1 1 −1 1 −1 1 −1 1 1 −1 1 1 −1 −1 1 −1 1 1 1 1 1 −1 −1 −1 1 −1 1 −1 |
| | −1 1 −1 −1 1 −1 −1 −1 1 1 1 1 1 −1 −1 −1 −1 −1 −1 1 −1 −1 1 1 1 −1 1 1 −1 1 1 |
| | −1 −1 −1 1 1 −1 1 1 −1 −1 1 1 −1 1 −1 1 1 1 −1 1 −1 1 −1 1 1 −1 −1 −1 −1 1 1 −1 |
| | −1 1 −1 −1 −1 1 1 1 −1 −1 1 1 1 −1 −1 1 1 1 1 1 −1 −1 −1 1 1 1 −1 1 −1 1 −1 1 1 |
| | −1 1 1 −1 1 −1 −1 1 −1 1 −1 −1 1 −1 −1 1 1 −1 1 1 −1 −1 −1 1 −1 1 −1 −1 1 −1 1 |
| | −1 −1 −1 1 1 −1 −1 −1 1 −1 −1 1 1 1 1 −1 −1 −1 1 1 −1 −1 −1 1 1 1 −1 −1 −1 1 −1 |
| | 1 −1 −1 −1 −1 1 1 1 1 1 1 1 −1 1 1 1 −1 −1 −1 −1 1 1 −1 −1 −1 −1 −1 1 −1 −1 1 |
| | −1 1 1 −1 1 1 −1 −1 −1 −1 1 −1 −1 −1 1 −1 1 −1 −1 −1 −1 −1 1 −1 1 −1 −1 −1 −1 |
| | 1 −1 1 −1 1 −1 −1 1 1 1 −1 −1 −1 1 −1 1 1 −1 1 −1 −1 −1 −1 1 1 −1 1 −1 −1 1 1 |
| | −1 −1 1 −1 1 1 1 1 1 1 1 −1 1 1 1 1 1 −1 −1 −1 1 1 1 1 −1 −1 1 1 1 −1 1 −1 1 −1 1 |
| | 1 1 −1 1 −1 −1 −1 1 −1 1 1 −1 −1 −1 1 1 −1 −1 −1 1 1 −1 1 −1 −1 −1 −1 −1 1 1 −1 |
| | −1 1 −1 −1 −1 −1 −1 1 −1 1 1 −1 −1 1 −1 1 1 −1 −1 −1 1 1 −1 1 1 1 1 1 1 1 1 1 −1 |
| | −1 1 −1 1 1 −1 1 −1 −1 −1 −1 −1 −1 −1 1 1 −1 −1 −1 1 −1 1 −1 −1 −1 −1 −1 −1 1 |
| | 1 −1 1 −1 1 −1 1 1 −1 1 1 1 −1 −1 −1 −1 −1 −1 1 1 1 −1 −1 −1 −1 1 −1 −1 −1 −1 |
| | −1 1 1 1 1 −1 −1 −1 −1 −1 −1 1 −1 1 −1 1 1 1 1 −1 1 −1 1 −1 −1 1 −1 −1 1 −1 1 |
| | −1 −1 1 −1 −1 −1 −1 −1 1 −1 −1 1 1 −1 −1 1 −1 1 −1 1 −1 1 −1 −1 1 1 1 −1 1 1 1 |
| | −1 −1 1 1 −1 1 −1 −1 −1 −1 −1 1 −1 1 −1 1 1 −1 1 1 1 1 −1 1 −1 1 1 −1 1 1 1 −1 |
| | −1 1 1 −1 −1 −1 1 −1 1 1 −1 −1 1 1 1 1 1 1 1 1 1 1 1 −1 1 −1 1 −1 −1 −1 1 1 −1 1 |
| | 1 −1 1 1 1 1 −1 1 1 1 −1 −1 −1 −1 −1 −1 −1 −1 1 −1 1 −1 1 −1 1 −1 −1 −1 1 −1 −1 |
| | −1 −1 −1 −1 −1 −1 1 −1 −1 −1 −1 −1 −1 1 1 −1 1 1 −1 −1 1 −1 −1 −1 −1 −1 −1 −1 |
| | −1 1 1 1 −1 −1 1 −1 −1 −1 1 1 1 −1 1 −1 1 1 1 −1 −1 −1 −1 1 1 −1 1 1 −1 −1 −1 |
| | −1 1 −1 1 1 1 −1 −1 −1 1 1 1 −1 1 −1 −1 1 1 1 1 1 −1 1 −1 −1 −1 1 1 −1 1 1 −1 −1 |
| | −1 1 1 1 1 −1 −1 1 −1 −1 −1 1 1 1 1 −1 −1 1 −1 1 1 1 1 −1 1 1 1 −1 −1 1 1 −1 −1 1 |
| | −1 −1 1 −1 −1 1 −1 −1 1 1 1 −1 −1 −1 −1 −1 1 −1 1 −1 −1 −1 1 −1 −1 1 1 1 1 1 −1 |
| | 1 1 −1 1 1 −1 1 −1 −1 1 −1 1 −1 1 1 −1 −1 −1 −1 −1 −1 −1 −1 −1 −1 1 1 −1 1 1 |
| | −1 1 −1 −1 −1 1 −1 1 1 1 −1 1 1 −1 1 1 −1 1 −1 −1 1 1 −1 −1 −1 −1 −1 1 −1 −1 −1 |
| | 1 1 1 1 1 −1 1 1 −1 −1 1 1 1 1 −1 1 1 −1 −1 −1 1 −1 −1 −1 −1 −1 1 −1 −1 −1 1 1 |
| | −1 −1 1 −1 −1 1 1 1 −1 1 1 1 1 −1 −1 1 1 −1 1 −1 −1 1 −1 1 1 1 −1 1 1 1 1 1 1 −1 |
| | 1 −1 1 −1 −1 1 −1 1 −1 −1 1 1 −1 −1 1 1 −1 −1 −1 −1 1 1 −1 −1 −1 −1 1 −1 −1 −1 |
| | −1 −1 −1 −1 1 1 1 −1 1 1 1 −1 1 −1 −1 1 −1 −1 −1 1 −1 1 −1 −1 −1 1 1 1 −1 −1 −1 |
| | 1 1 1 1 −1 1 1 −1 1 1 −1 1 1 −1 −1 1 1 1 1 −1 −1 −1 −1 −1 1 1 1 1 1 −1 −1 1 1 1 1 |
| | −1 −1 −1 −1 1 −1 1 1 −1 1 1 1 −1 1 1 1 1 1 1 1 −1 −1 1 1 −1 −1 1 −1 −1 −1 1 −1 1 |
| | 1 −1 −1 −1 −1 −1 −1 −1 1 1 −1 1 −1 −1 −1 −1 1 1 −1 −1 1 −1 1 −1 −1 1 −1 1 1 1 1 |
| | −1 −1 −1 −1 1 1 1 1 1 −1 −1 1 −1 −1 1 −1 1 −1 1 −1 1 1 1 −1 −1 −1 −1 1 −1 1 1 1 |
| | 1 −1 1 1 −1 −1 1 1 −1 1 1 1 −1 1 1 −1 1 1 −1 −1 1 −1 1 −1 −1 1 1 1 −1 1 −1 1 1 −1 |
| | −1 −1 1 1 −1 1 −1 −1 1 1 −1 1 −1 −1 1 −1 1 −1 −1 −1 1 −1 1 −1 −1 −1 −1 1 −1 −1 |
| | 1 1 −1 1 1 −1 −1 1 −1 −1 1 1 −1 −1 1 −1 −1 −1 −1 −1 −1 1 1 1 1 −1 −1 1 −1 1 −1 |
| | −1 1 −1 −1 1 −1 1 1 1 1 −1 1 −1 1 1 −1 −1 −1 1 −1 1 1 −1 1 1 −1 1 −1 −1 −1 1 1 |
| | −1 1 1 1 1 −1 1 −1 1 −1 1 1 1 −1 −1 1 −1 −1 −1 −1 −1 −1 1 −1 −1 1 −1 1 1 1 −1 1 |
| | −1 1 −1 1 −1 1 −1 −1 1 1 −1 1 1 1 −1 −1 1 −1 −1 −1 1 −1 1 1 1 1 −1 −1 1 −1 1 −1 |
| | −1 −1 1 −1 1 1 1 −1 −1 −1 −1 1 −1 −1 −1 1 1 1 1 −1 1 1 1 1 −1 −1 −1 −1 1 −1 1 |
| | −1 1 1 1 −1 −1 −1 −1 −1 1 1 1 −1 1 1 −1 −1 −1 −1 1 −1 1 −1 −1 −1 −1 1 1 −1 −1 1 |
| | 1 −1 −1 −1 −1 −1 −1 −1 −1 1 −1 −1 1 1 −1 −1 −1 1 1 −1 −1 −1 −1 1 1 1 1 1 1 −1 |
| | −1 −1 1 −1 1 1 −1 −1 −1 1 −1 1 −1 −1 −1 1 1 −1 1 −1 −1 −1 1 −1 −1 1 1 1 −1 −1 |
| | −1 1 −1 −1 −1 −1 1 1 −1 1 1 −1 1 −1 1 1 1 −1 −1 1 −1 1 −1 1 −1 1 −1 1 −1 1 1 1 1 |
| | −1 −1 1 −1 1 1 1 −1 1 1 1 −1 −1 1 −1 −1 −1 −1 1 1 1 −1 1 1 1 −1 −1 1 −1 1 1 −1 1 |
| | −1 1 1 −1 −1 1 −1 −1 −1 1 −1 −1 1 1 −1 1 1 1 −1 −1 −1 1 −1 −1 −1 −1 −1 −1 −1 1 |
| | −1 −1 −1 1 −1 1 1 −1 1 −1 1 −1 1 1 −1 1 −1 −1 −1 −1 1 −1 1 1 −1 1 1 −1 1 1 1 −1 |
| | 1 −1 −1 −1 −1 −1 1 −1 1 1 −1 1 −1 −1 1 −1 −1 1 1 −1 1 −1 1 −1 −1 −1 −1 −1 1 1 1 |
| | −1 1 1 1 1 −1 −1 −1 −1 −1 1 1 −1 −1 1 −1 1 1 −1 −1 −1 −1 −1 −1 1 −1 1 −1 −1 −1 |
| | 1 1 1 1 1 −1 1 −1 1 −1 1 −1 1 −1 1 −1 1 −1 −1 1 −1 1 1 1 −1 −1 1 −1 1 −1 −1 1 1 |
| | −1 −1 −1 −1 −1 −1 1 −1 −1 −1 1 −1 −1 −1 −1 1 1 1 1 −1 −1 −1 1 −1 1 1 1 −1 1 1 1 |
| | −1 1 −1 −1 −1 1 −1 −1 −1 −1 −1 1 1 −1 1 1 −1 1 1 1 −1 1 1 1 −1 −1 1 1 1 −1 −1 |
| | −1 1 −1 1 −1 1 1 −1 1 −1 1 −1 −1 −1 1 −1 1 −1 −1 1 1 1 −1 1 1 −1 1 −1 1 −1 −1 |
| | −1 1 1 −1 −1 −1 −1 1 −1 1 −1 1 −1 1 1 −1 1 1 1 1 1 −1 −1 1 −1 −1 −1 −1 −1 −1 −1 |
| | 1 −1 1 1 1 −1 −1 1 1 −1 1 1 −1 1 −1 1 −1 1 1 −1 −1 1 −1 −1 1 1 1 −1 −1 −1 1 1 1 |
| | −1 −1 −1 1 1 −1 −1 −1 1 −1 −1 −1 −1 1 1 1 −1 1 −1 −1 −1 −1 −1 −1 −1 −1 1 1 −1 |
| | 1 −1 1 1 −1 1 −1 −1 1 −1 1 1 −1 −1 −1 1 −1 −1 −1 1 −1 −1 −1 1 1 −1 1 −1 1 1 −1 |
| | 1 1 1 1 −1 −1 1 1 1 1 1 −1 −1 1 −1 1 1 1 1 1 −1 1 1 1 −1 −1 −1 1 −1 1 −1 1 −1 1 1 |
| | −1 −1 −1 1 1 −1 −1 1 −1 1 −1 −1 −1 1 1 1 −1 1 1 1 1 −1 1 1 −1 −1 −1 1 1 1 −1 −1 |
| | 1 1 1 1 1 1 1 −1 1 −1 1 1 −1 1 1 −1 1 −1 1 −1 −1 1 1 −1 −1 1 1 1 1 −1 −1 −1 1 1 1 |
| | 1 −1 1 −1 1 1 1 1 1 −1 1 1 1 1 1 −1 1 1 1 1 −1 1 1 1 −1 1 1 −1 −1 1 −1 1 −1 1 1 −1 |
| | 1 1 −1 1 1 1 1 −1 −1 −1 1 −1 1 −1 1 1 1 −1 −1 1 1 −1 1 −1 1 1 −1 −1 −1 −1 −1 1 |
| | −1 1 −1 1 −1 −1 −1 1 −1 −1 1 1 −1 −1 1 −1 −1 1 1 −1 −1 −1 1 −1 −1 1 −1 1 −1 −1 |
| | 1 1 −1 1 −1 1 −1 1 −1 1 −1 −1 −1 −1 −1 1 −1 1 1 1 −1 −1 −1 −1 −1 1 −1 −1 −1 1 |
| | −1 −1 1 1 1 1 −1 1 1 1 1 1 −1 1 −1 −1 1 −1 −1 1 −1 1 −1 1 −1 −1 −1 1 −1 1 −1 1 |
| | −1 1 1 1 1 −1 1 −1 −1 1 −1 1 1 −1 −1 1 −1 −1 −1 1 1 1 1 1 1 1 −1 −1 1 −1 −1 1 1 1 |
| | 1 1 1 −1 −1 1 −1 1 −1 −1 −1 −1 1 1 1 −1 −1 1 1 1 1 −1 −1 1 −1 −1 −1 −1 −1 1 1 1 |
| | −1 −1 1 −1 1 1 1 1 −1 −1 −1 1 −1 1 1 −1 1 1 1 −1 −1 −1 1 1 −1 1 −1 1 1 1 1 −1 1 |
| | −1 1 1 1 1 −1 1 1 1 −1 1 −1 1 −1 1 1 1 1 −1 −1 −1 1 1 1 −1 −1 −1 −1 −1 −1 −1 1 1 |
| | 1 1 1 −1 1 1 −1 1 −1 1 1 −1 −1 −1 −1 1 −1 −1 1 1 1 1 1 1 1 −1 −1 −1 −1 1 1 −1 −1 |
| | −1 1 1 1 −1 1 1 1 −1 −1 −1 1 1 1 1 1 1 −1 −1 −1 −1 1 1 1 1 −1 1 −1 1 1 −1 −1 1 −1 |
| | −1 1 −1 −1 −1 −1 1 1 −1 −1 1 −1 −1 1 −1 1 1 1 −1 −1 −1 −1 −1 −1 1 −1 −1 −1 −1 |
| | 1 −1 −1 1 1 −1 −1 −1 −1 −1 −1 −1 1 −1 −1 −1 −1 1 1 1 1 1 1 −1 1 1 1 −1 −1 1 1 1 |
| | 1 1 −1 1 1 1 1 −1 −1 −1 1 −1 −1 1 1 1 −1 −1 1 −1 −1 −1 1 −1 −1 −1 1 1 1 −1 −1 1 |
| | −1 −1 −1 −1 −1 1 −1 −1 −1 −1 −1 −1 −1 −1 −1 1 −1 −1 1 −1 1 −1 −1 −1 1 1 1 1 |
| | −1 1 1 −1 −1 −1 −1 1 −1 −1 1 −1 −1 1 1 −1 1 1 1 1 −1 1 1 1 1 1 −1 −1 1 −1 1 1 −1 |
| | −1 1 −1 −1 1 −1 1 1 −1 1 −1 −1 1 −1 1 −1 1 −1 −1 −1 −1 1 1 −1 −1 −1 −1 −1 −1 1 |
| | −1 1 1 1 −1 1 −1 1 −1 −1 1 1 −1 1 1 −1 1 −1 1 1 −1 1 −1 1 1 1 1 −1 1 1 −1 1 1 −1 |
| | −1 −1 −1 −1 −1 1 −1 −1 1 −1 −1 −1 1 −1 −1 −1 −1 1 −1 −1 1 −1 1 −1 −1 1 −1 1 1 |
| | −1 −1 −1 −1 1 −1 −1 −1 −1 1 1 −1 1 −1 1 1 −1 −1 1 −1 1 1 1 −1 1 1 −1 1 −1 1 1 |
| | −1 1 1 −1 1 1 −1 −1 −1 −1 1 1 1 −1 1 1 1 1 1 1 −1 −1 1 1 −1 1 1 1 −1 1 −1 1 1 1 1 |
| | −1 −1 1 −1 −1 −1 1 −1 −1 1 −1 1 1 1 −1 −1 1 1 −1 −1 −1 −1 1 1 1 1 −1 −1 −1 −1 1 |
| | 1 1 −1 −1 −1 −1 −1 −1 1 −1 1 1 −1 1 1 −1 −1 −1 1 −1 −1 −1 1 1 1 −1 1 −1 −1 −1 1 |
| | −1 1 −1 1 −1 −1 −1 1 1 1 1 1 1 −1 −1 1 1 1 1 −1 1 1 −1 1 1 1 −1 1 −1 1 1 −1 −1 −1 |
| | −1 −1 −1 1 1 −1 −1 −1 1 1 −1 −1 −1 1 −1 1 1 −1 1 −1 1 1 −1 1 −1 −1 −1 1 1 1 1 |
| | −1 1 −1 1 −1 −1 1 1 1 1 −1 −1 −1 1 −1 1 −1 −1 −1 1 −1 1 1 −1 1 −1 −1 1 1 1 1 1 1 |
| | 1 1 −1 1 −1 −1 −1 1 −1 −1 −1 1 1 1 1 1 1 −1 1 −1 1 1 −1 −1 −1 −1 1 1 1 1 1 −1 1 |
| | −1 −1 −1 −1 −1 −1 1 −1 −1 1 1 −1 1 1 1 1 1 −1 1 1 −1 1 1 1 −1 −1 1 1 1 1 −1 1 1 1 |
| | −1 1 1 1 1 1 −1 −1 −1 −1 −1 1 1 1 −1 −1 −1 −1 −1 1 −1 −1 1 −1 −1 −1 −1 1 −1 −1 |
| | 1 1 1 1 −1 −1 1 −1 1 −1 1 −1 −1 −1 −1 −1 −1 −1 −1 1 −1 1 1 −1 −1 1 1 −1 1 −1 1 |
| | −1 −1 −1 1 1 1 1 −1 −1 −1 −1 −1 1 −1 −1 1 1 1 −1 −1 −1 −1 1 −1 −1 1 1 −1 1 −1 1 |
| | −1 1 1 −1 −1 −1 1 −1 1 −1 1 1 1 1 1 1 1 1 1 1 −1 −1 −1 −1 −1 1 1 −1 1 −1 −1 1 −1 |
| | −1 1 1 1 −1 −1 1 1 −1 1 1 1 1 1 1 1 −1 −1 −1 −1 −1 −1 −1 −1 1 1 −1 −1 1 1 1 1 1 1 |
| | 1 −1 −1 1 1 1 1 1 −1 1 −1 −1 1 −1 1 −1 −1 1 1 1 1 1 1 1 −1 1 1 −1 1 −1 −1 1 1 −1 |
| | 1 1 −1 −1 −1 −1 1 1 −1 1 1 1 −1 1 −1 −1 1 −1 1 1 1 −1 −1 −1 1 −1 1 1 −1 1 1 −1 |
| | −1 −1 1 −1 1 1 1 1 −1 −1 −1 1 1 −1 1 −1 −1 1 −1 1 1 −1 1 1 1 −1 1 −1 −1 1 1 −1 1 |
| | 1 1 −1 1 −1 −1 −1 1 1 1 −1 −1 1 1 −1 1 −1 1 −1 1 −1 −1 1 −1 −1 1 −1 −1 1 −1 1 1 |
| | −1 1 1 1 1 −1 −1 −1 −1 1 1 −1 −1 1 −1 1 1 1 1 −1 −1 1 −1 −1 1 −1 −1 −1 −1 −1 −1 |
| | −1 −1 −1 −1 1 −1 1 1 1 1 1 1 1 1 1 −1 1 −1 −1 1 −1 −1 −1 1 1 −1 −1 −1 1 1 −1 −1 |
| | 1 −1 −1 1 −1 −1 −1 1 −1 1 −1 1 1 1 1 −1 −1 1 1 −1 1 1 1 1 −1 −1 1 −1 1 −1 1 1 1 |
| | −1 −1 1 −1 1 1 −1 −1 1 1 1 1 −1 −1 1 1 −1 1 −1 1 −1 −1 1 −1 1 1 −1 −1 1 1 1 −1 1 |
| | −1 1 −1 −1 −1 1 −1 −1 −1 1 1 −1 −1 1 1 1 1 1 −1 −1 −1 −1 −1 1 −1 −1 −1 −1 1 −1 |
| | 1 −1 1 −1 1 −1 1 1 1 −1 1 −1 1 1 1 −1 −1 1 1 1 1 1 1 −1 1 1 −1 −1 1 1 −1 −1 −1 1 |
| | −1 −1 1 1 −1 −1 −1 −1 1 1 −1 1 1 −1 1 1 −1 1 1 1 −1 −1 1 −1 −1 1 −1 −1 1 −1 1 |
| | −1 1 1 1 −1 1 1 1 1 −1 1 1 1 1 −1 1 −1 1 1 1 −1 1 1 1 −1 −1 −1 1 −1 −1 1 1 −1 −1 |
| | 1 1 1 1 1 1 −1 1 −1 1 −1 1 −1 −1 1 1 −1 −1 −1 1 −1 1 1 1 1 1 1 −1 1 −1 −1 −1 1 1 |
| | 1 −1 1 −1 1 −1 −1 −1 −1 1 −1 −1 −1 1 1 1 −1 1 1 1 −1 1 1 1 1 −1 1 −1 −1 1 −1 −1 |
| | −1 −1 −1 −1 −1 1 1 −1 1 1 1 −1 −1 −1 1 1 1 −1 −1 1 −1 1 −1 1 −1 −1 1 1 −1 −1 1 |
| | −1 −1 1 −1 1 −1 −1 −1 −1 1 −1 1 1 −1 −1 −1 −1 1 −1 1 1 −1 1 −1 −1 −1 1 −1 1 −1 |
| | −1 −1 1 −1 −1 −1 −1 1 1 −1 −1 −1 −1 1 1 1 −1 −1 1 −1 1 −1 −1 1 −1 1 −1 −1 1 −1 |
| | 1 −1 1 −1 −1 1 1 1 1 1 −1 1 1 1 −1 1 −1 −1 −1 −1 1 −1 −1 1 −1 −1 −1 1 1 1 −1 −1 |
| | −1 −1 1 −1 1 1 −1 −1 −1 1 −1 −1 1 −1 −1 −1 1 1 −1 1 −1 −1 1 1 1 −1 −1 −1 −1 −1 |
| | −1 1 1 −1 1 −1 −1 1 1 1 1 1 −1 −1 1 −1 −1 −1 1 1 −1 −1 −1 −1 −1 −1 −1 −1 −1 1 |
| | −1 1 −1 −1 1 1 −1 1 −1 −1 1 1 −1 −1 −1 1 1 1 −1 1 −1 −1 −1 −1 1 1 −1 −1 −1 1 1 |
| | −1 1 1 1 −1 −1 1 1 −1 1 1 1 −1 −1 1 1 1 −1 1 1 1 −1 −1 −1 −1 −1 1 1 −1 1 1 1 1 −1 |
| | 1 1 −1 −1 1 −1 1 1 1 −1 −1 −1 −1 1 1 1 −1 1 −1 1 −1 1 −1 1 1 1 1 1 1 1 −1 −1 1 −1 |
| | 1 −1 1 1 −1 1 −1 1 1 1 −1 1 1 1 1 1 −1 1 1 −1 −1 −1 1 −1 1 1 −1 −1 −1 −1 1 1 −1 1 |
| | −1 −1 −1 1 1 −1 −1 1 −1 1 1 −1 1 1 −1 −1 1 1 1 −1 1 −1 −1 1 −1 −1 −1 −1 1 1 −1 |
| | 1 −1 −1 −1 −1 −1 −1 −1 −1 −1 −1 −1 1 1 1 −1 1 −1 −1 −1 1 1 −1 −1 1 1 −1 1 −1 |
| | −1 1 1 1 −1 1 1 −1 −1 1 1 −1 1 −1 −1 −1 1 −1 −1 −1 −1 1 −1 1 −1 −1 1 1 −1 −1 1 |
| | −1 1 −1 −1 1 1 −1 1 1 −1 −1 1 1 1 1 1 1 −1 −1 1 1 −1 −1 −1 1 −1 −1 −1 −1 −1 −1 |
| | 1 −1 −1 −1 1 1 1 −1 −1 −1 1 −1 −1 1 −1 −1 1 1 −1 −1 −1 1 1 1 1 −1 −1 −1 1 −1 −1 |
| | −1 1 −1 −1 1 −1 1 −1 −1 −1 −1 −1 1 1 1 1 −1 1 1 −1 −1 1 1 1 −1 1 1 1 1 −1 1 −1 1 |
| | −1 −1 −1 1 −1 1 1 1 1 1 −1 −1 −1 −1 1 1 −1 1 1 1 1 |
| 5 | −1 −1 −1 −1 −1 −1 −1 −1 −1 −1 −1 −1 −1 1 −1 −1 1 1 −1 −1 1 1 1 −1 1 −1 −1 1 1 |
| | −1 1 1 −1 1 1 −1 1 −1 −1 −1 1 −1 −1 −1 −1 1 1 1 −1 1 −1 −1 1 −1 −1 1 1 1 1 −1 |
| | −1 −1 1 1 −1 −1 −1 −1 1 −1 1 1 1 −1 1 −1 −1 −1 −1 1 −1 1 1 −1 −1 1 1 −1 −1 −1 1 |
| | −1 −1 1 −1 1 −1 −1 −1 −1 1 1 1 1 1 1 −1 1 1 −1 −1 1 1 1 −1 −1 −1 1 1 1 1 1 −1 −1 |
| | 1 1 −1 1 −1 −1 −1 −1 1 1 −1 1 −1 1 −1 −1 1 1 −1 1 1 1 −1 −1 −1 1 −1 −1 −1 1 1 1 |
| | 1 −1 −1 1 1 −1 −1 1 −1 −1 1 −1 −1 1 −1 −1 1 1 1 −1 1 1 −1 1 1 −1 −1 −1 1 −1 1 1 |
| | −1 1 −1 1 1 1 −1 1 −1 −1 −1 1 1 1 −1 −1 1 1 −1 −1 −1 1 −1 1 1 1 −1 1 1 1 1 −1 1 |
| | −1 1 1 −1 1 −1 −1 −1 1 −1 1 −1 1 −1 −1 −1 1 −1 1 −1 −1 −1 −1 −1 −1 −1 −1 −1 1 |
| | 1 1 −1 1 −1 −1 1 1 1 1 −1 1 −1 −1 1 −1 1 −1 1 1 −1 1 1 1 −1 1 −1 1 1 1 1 1 −1 1 1 |
| | −1 1 −1 −1 −1 1 −1 1 1 −1 −1 1 −1 −1 −1 −1 −1 −1 1 1 1 −1 1 −1 1 −1 1 −1 1 1 1 |
| | 1 −1 1 1 −1 1 1 −1 −1 −1 −1 1 1 −1 −1 −1 −1 −1 1 1 1 −1 1 −1 1 1 −1 −1 −1 1 −1 |
| | 1 1 1 1 1 −1 −1 −1 1 −1 1 −1 1 1 1 −1 1 1 −1 1 1 1 −1 −1 1 1 1 −1 −1 −1 1 −1 1 −1 |
| | −1 1 1 −1 −1 1 1 1 −1 −1 1 −1 −1 1 1 1 −1 −1 1 −1 1 −1 −1 1 −1 −1 1 −1 1 1 1 −1 |
| | −1 1 1 −1 1 −1 −1 −1 1 −1 1 1 1 1 1 1 −1 1 −1 1 −1 1 −1 −1 1 1 1 1 1 −1 −1 −1 −1 |
| | 1 −1 1 −1 1 −1 −1 −1 −1 −1 −1 1 1 1 1 1 1 −1 1 −1 1 −1 −1 1 −1 −1 1 −1 1 −1 −1 |
| | −1 1 1 −1 −1 −1 −1 −1 1 −1 1 1 −1 1 −1 −1 1 1 −1 −1 −1 1 −1 −1 −1 −1 −1 1 1 1 1 |
| | −1 −1 1 −1 1 1 1 −1 −1 1 −1 −1 −1 1 1 1 −1 1 −1 1 −1 1 1 −1 1 −1 1 1 1 −1 −1 1 |
| | −1 1 1 −1 1 1 −1 1 −1 1 1 −1 −1 −1 −1 −1 1 1 −1 1 −1 −1 1 1 −1 −1 −1 −1 1 −1 1 |
| | −1 1 1 −1 1 1 1 1 −1 −1 −1 1 −1 1 −1 −1 1 −1 1 −1 −1 1 −1 −1 1 1 −1 1 −1 −1 1 1 |
| | −1 −1 1 1 1 1 1 1 1 −1 −1 1 −1 −1 −1 −1 1 −1 −1 1 1 1 1 1 1 −1 1 −1 1 1 1 1 1 −1 |
| | −1 −1 −1 −1 −1 1 −1 −1 −1 1 −1 1 1 1 1 −1 1 1 −1 1 −1 1 −1 1 −1 −1 1 1 −1 −1 1 |
| | 1 −1 1 −1 −1 −1 1 1 −1 1 −1 1 −1 1 1 1 −1 −1 1 −1 −1 1 1 −1 −1 1 −1 1 −1 1 1 −1 |
| | −1 1 1 −1 −1 −1 −1 1 −1 −1 −1 −1 −1 1 −1 −1 −1 −1 −1 1 −1 1 1 −1 1 1 1 1 −1 −1 |
| | 1 −1 −1 −1 −1 1 1 1 1 −1 1 −1 1 −1 −1 1 1 −1 −1 1 −1 1 1 1 −1 1 1 −1 −1 1 1 −1 1 |
| | 1 −1 1 1 1 1 1 1 1 −1 1 1 1 −1 −1 1 1 1 −1 1 1 1 1 1 1 −1 −1 1 −1 1 −1 −1 1 1 −1 |
| | −1 1 −1 −1 −1 1 1 1 −1 −1 1 1 1 1 −1 −1 −1 −1 1 −1 −1 1 −1 −1 −1 −1 −1 −1 −1 |
| | −1 −1 −1 1 −1 1 −1 1 1 −1 −1 1 −1 −1 1 1 1 −1 1 1 1 −1 1 1 −1 1 1 1 1 1 1 −1 1 1 |
| | −1 1 1 −1 −1 1 1 1 −1 −1 1 −1 1 −1 1 −1 −1 1 1 1 1 −1 1 −1 1 −1 −1 −1 −1 −1 1 1 |
| | 1 1 −1 1 −1 −1 −1 1 −1 −1 1 1 −1 1 1 −1 1 −1 −1 −1 1 1 1 −1 1 1 −1 1 1 1 −1 1 −1 |
| | 1 −1 −1 1 −1 −1 −1 1 1 1 −1 1 1 −1 −1 −1 1 1 1 1 1 1 −1 1 1 1 1 1 −1 1 1 −1 1 1 1 |
| | −1 −1 −1 −1 1 1 −1 1 1 1 1 −1 1 −1 −1 −1 1 1 −1 −1 −1 1 −1 −1 1 −1 −1 1 −1 1 −1 |
| | −1 1 −1 1 1 −1 1 −1 1 1 −1 −1 −1 1 1 1 −1 −1 −1 −1 1 1 1 1 1 1 −1 −1 −1 −1 1 1 |
| | −1 1 1 −1 −1 −1 −1 −1 1 −1 −1 1 −1 1 1 −1 −1 1 1 1 1 1 1 −1 −1 1 −1 1 1 1 1 −1 |
| | −1 1 1 1 −1 −1 −1 −1 −1 −1 1 1 −1 −1 1 1 1 −1 1 −1 1 −1 1 1 1 −1 −1 −1 1 −1 −1 |
| | 1 1 −1 −1 −1 1 1 −1 −1 −1 1 1 −1 1 −1 1 1 1 1 1 1 −1 −1 −1 1 −1 −1 −1 1 1 −1 −1 |
| | −1 1 1 −1 −1 1 1 −1 1 −1 1 −1 −1 −1 1 −1 1 −1 1 1 −1 1 −1 1 −1 1 1 1 −1 1 −1 −1 |
| | 1 1 −1 −1 1 1 −1 −1 1 −1 1 1 −1 −1 −1 −1 1 1 −1 −1 1 1 −1 −1 1 −1 −1 −1 −1 1 −1 |
| | 1 1 −1 −1 −1 −1 −1 1 −1 −1 −1 1 1 −1 −1 1 1 −1 1 1 −1 −1 1 −1 −1 −1 −1 −1 1 −1 |
| | 1 −1 −1 −1 −1 −1 −1 1 1 −1 −1 1 −1 −1 −1 −1 −1 −1 −1 −1 1 1 1 1 1 1 1 −1 −1 −1 |
| | −1 1 1 1 −1 1 1 −1 1 −1 1 1 −1 1 −1 1 1 −1 −1 1 −1 1 −1 −1 1 −1 1 1 1 −1 −1 −1 1 |
| | 1 −1 1 1 1 −1 1 1 −1 1 1 −1 −1 1 −1 −1 −1 1 1 1 1 1 1 −1 1 −1 −1 1 −1 −1 −1 1 1 1 |
| | 1 −1 1 1 −1 1 1 −1 1 1 −1 −1 1 1 −1 1 −1 −1 −1 −1 −1 −1 −1 −1 −1 −1 −1 1 1 1 1 |
| | −1 −1 1 1 −1 1 −1 −1 1 1 1 −1 −1 −1 −1 −1 −1 −1 −1 −1 1 1 −1 1 1 1 −1 −1 1 −1 1 |
| | −1 −1 1 1 1 1 1 1 −1 1 1 −1 1 −1 1 −1 −1 1 −1 −1 1 1 −1 −1 1 −1 −1 1 1 −1 −1 1 1 |
| | −1 −1 −1 1 1 −1 −1 1 −1 1 1 1 1 1 −1 1 1 −1 −1 1 −1 1 1 1 1 −1 −1 −1 −1 1 1 −1 1 |
| | −1 1 −1 1 −1 1 1 1 −1 1 1 −1 −1 −1 1 1 −1 −1 1 −1 −1 −1 1 −1 1 1 1 −1 −1 −1 −1 |
| | 1 −1 1 −1 1 1 1 −1 1 −1 1 1 −1 1 1 −1 −1 1 1 1 1 1 1 1 1 1 1 1 −1 1 −1 −1 −1 −1 |
| | −1 −1 −1 1 −1 1 1 −1 −1 −1 −1 1 −1 −1 1 −1 −1 1 −1 1 −1 1 −1 1 1 −1 −1 1 −1 1 |
| | 1 −1 −1 1 −1 −1 −1 1 1 −1 −1 1 −1 −1 −1 −1 1 1 −1 1 1 −1 1 −1 1 1 −1 1 1 −1 1 1 |
| | −1 −1 −1 −1 −1 −1 −1 1 −1 1 −1 −1 1 1 1 −1 1 1 −1 −1 1 1 1 1 −1 1 −1 −1 −1 −1 |
| | −1 1 −1 −1 1 −1 −1 1 1 1 −1 −1 −1 −1 −1 1 1 −1 1 1 −1 −1 −1 1 1 1 1 −1 −1 −1 −1 |
| | 1 −1 1 −1 −1 1 −1 1 −1 1 −1 −1 1 1 −1 −1 −1 −1 −1 −1 −1 1 −1 −1 1 −1 −1 1 −1 |
| | −1 −1 1 −1 1 −1 −1 1 −1 −1 −1 1 −1 1 1 −1 −1 1 1 1 −1 1 −1 1 1 −1 1 −1 −1 1 −1 |
| | −1 −1 −1 −1 −1 1 −1 1 1 −1 1 −1 1 −1 1 1 −1 1 1 1 −1 −1 1 1 −1 1 −1 1 1 1 1 1 −1 |
| | 1 −1 1 1 1 −1 1 1 1 1 1 1 1 −1 −1 1 −1 1 1 −1 −1 −1 1 1 −1 1 1 −1 −1 1 1 1 1 −1 |
| | −1 1 −1 1 −1 1 1 1 −1 1 1 1 −1 1 −1 −1 1 1 −1 1 −1 1 1 −1 −1 −1 −1 1 −1 1 1 1 1 |
| | −1 −1 1 −1 1 1 1 1 1 1 1 −1 1 −1 1 −1 −1 1 −1 −1 −1 1 1 −1 −1 −1 −1 1 1 1 −1 |
| | −1 1 −1 1 1 1 −1 −1 −1 1 −1 1 1 −1 1 1 1 −1 −1 1 −1 1 1 1 1 −1 1 −1 1 −1 −1 1 −1 |
| | 1 −1 −1 −1 −1 1 −1 −1 1 −1 1 1 1 −1 −1 −1 −1 −1 −1 −1 1 −1 −1 −1 1 −1 −1 −1 1 |
| | −1 −1 −1 1 1 1 −1 −1 1 −1 −1 1 1 −1 1 −1 −1 −1 −1 −1 1 1 −1 1 −1 1 1 −1 1 1 1 1 |
| | −1 1 1 1 1 1 1 −1 −1 −1 1 1 1 −1 −1 1 1 −1 1 1 1 1 1 −1 1 1 1 1 −1 −1 1 1 1 1 −1 1 |
| | 1 1 1 −1 −1 1 −1 −1 1 1 1 −1 1 −1 −1 −1 −1 1 1 1 −1 1 1 −1 −1 1 1 −1 −1 −1 −1 |
| | −1 1 −1 1 −1 1 1 1 −1 −1 1 1 −1 −1 −1 1 1 −1 1 −1 −1 −1 1 −1 1 −1 −1 1 −1 1 1 1 |
| | 1 1 −1 −1 1 1 1 −1 1 −1 −1 −1 1 1 −1 −1 1 −1 −1 1 1 1 −1 −1 −1 1 1 1 −1 −1 −1 1 |
| | 1 −1 −1 −1 −1 −1 1 1 −1 1 1 1 1 −1 −1 1 −1 1 1 −1 −1 1 −1 1 1 1 −1 −1 1 1 1 −1 |
| | −1 1 −1 −1 −1 −1 1 1 −1 −1 −1 −1 −1 −1 −1 1 1 1 1 1 −1 −1 −1 1 −1 1 1 −1 1 −1 |
| | −1 −1 1 1 1 1 −1 1 1 1 −1 1 1 1 −1 −1 1 1 1 1 −1 1 −1 1 −1 1 1 −1 1 1 −1 1 −1 −1 |
| | 1 1 1 1 1 1 −1 −1 −1 −1 −1 −1 −1 −1 1 1 −1 1 −1 −1 −1 1 1 1 1 1 −1 1 −1 −1 −1 1 |
| | −1 −1 −1 −1 −1 −1 1 1 1 1 −1 −1 −1 −1 −1 −1 −1 1 1 −1 1 −1 1 1 1 −1 1 −1 1 1 1 |
| | −1 1 1 −1 −1 1 −1 1 1 −1 −1 −1 1 −1 1 1 −1 −1 1 1 −1 1 1 1 1 −1 −1 −1 −1 −1 −1 |
| | 1 1 −1 1 −1 1 −1 −1 −1 −1 −1 −1 1 −1 −1 1 −1 1 1 1 1 1 −1 1 −1 1 −1 −1 −1 −1 1 |
| | −1 1 −1 1 1 1 1 −1 −1 −1 1 1 1 −1 −1 −1 −1 −1 −1 1 −1 1 −1 −1 1 −1 −1 −1 −1 1 1 |
| | −1 −1 1 1 −1 1 −1 −1 1 −1 1 1 1 1 1 1 1 1 −1 1 1 1 1 −1 −1 −1 −1 1 −1 −1 −1 1 −1 |
| | 1 −1 1 −1 1 −1 −1 1 −1 1 1 1 1 −1 1 −1 −1 1 −1 −1 −1 −1 −1 1 −1 −1 −1 1 1 1 1 1 |
| | −1 −1 −1 1 1 −1 1 1 1 1 −1 1 1 1 −1 −1 1 1 −1 1 1 −1 1 −1 1 −1 −1 −1 −1 1 −1 −1 |
| | 1 1 −1 1 −1 −1 1 −1 1 −1 −1 1 −1 1 −1 1 1 1 1 −1 −1 1 −1 1 −1 −1 1 −1 1 −1 −1 |
| | −1 1 −1 −1 1 1 1 1 −1 1 −1 1 1 1 −1 1 −1 −1 1 −1 1 −1 −1 1 1 −1 −1 −1 1 −1 1 1 |
| | −1 1 1 −1 1 −1 −1 −1 −1 1 −1 1 −1 −1 1 −1 −1 1 1 1 −1 −1 1 1 −1 −1 1 1 1 −1 −1 |
| | −1 1 −1 −1 1 −1 −1 1 1 −1 −1 1 1 1 1 −1 −1 1 1 −1 −1 −1 1 −1 −1 −1 1 1 1 −1 1 |
| | −1 −1 1 1 −1 −1 −1 −1 −1 1 1 1 1 −1 −1 −1 1 1 −1 1 1 −1 −1 −1 −1 1 −1 −1 1 1 1 |
| | 1 −1 −1 −1 −1 −1 −1 1 −1 1 1 1 1 1 −1 1 −1 −1 1 −1 1 −1 −1 −1 −1 −1 1 −1 −1 −1 |
| | −1 1 −1 −1 −1 1 1 1 −1 1 1 1 1 −1 −1 1 −1 1 −1 1 −1 −1 −1 −1 1 −1 −1 −1 −1 −1 |
| | −1 −1 1 1 1 1 −1 1 −1 1 1 1 1 −1 −1 1 1 1 1 1 −1 1 −1 1 1 −1 −1 −1 −1 −1 −1 −1 |
| | −1 −1 −1 1 1 −1 −1 −1 1 1 −1 −1 −1 −1 −1 −1 −1 −1 −1 1 −1 1 1 −1 1 1 −1 −1 −1 |
| | 1 1 1 −1 1 −1 1 −1 −1 −1 −1 −1 −1 −1 1 −1 −1 −1 −1 1 −1 1 1 1 −1 1 1 1 −1 1 1 1 |
| | 1 −1 −1 −1 −1 −1 1 −1 1 1 1 1 1 −1 −1 1 1 1 1 1 −1 −1 1 1 −1 −1 1 −1 1 −1 −1 1 |
| | 1 1 −1 −1 1 1 1 −1 −1 −1 −1 1 1 1 −1 −1 1 1 −1 1 −1 −1 1 −1 −1 −1 1 −1 1 −1 1 |
| | −1 −1 1 −1 −1 −1 −1 1 −1 1 −1 −1 1 1 1 1 −1 1 1 −1 −1 1 −1 1 −1 −1 1 1 −1 1 −1 |
| | −1 1 −1 −1 1 −1 −1 −1 −1 −1 −1 1 1 −1 1 1 1 1 1 1 1 1 1 −1 −1 1 1 −1 −1 −1 −1 |
| | −1 1 1 −1 −1 −1 1 −1 −1 1 1 1 1 1 1 1 −1 −1 −1 1 −1 1 −1 −1 −1 1 1 1 −1 −1 −1 1 |
| | 1 1 1 −1 1 −1 −1 1 1 1 1 −1 −1 1 −1 −1 −1 −1 −1 −1 1 −1 −1 −1 −1 −1 −1 −1 −1 |
| | −1 1 −1 −1 −1 −1 −1 1 1 −1 1 1 1 −1 1 −1 −1 −1 −1 1 1 −1 1 1 −1 −1 1 1 −1 −1 −1 |
| | 1 1 1 1 1 1 1 −1 1 −1 1 −1 −1 −1 1 −1 −1 −1 −1 −1 1 −1 1 −1 1 1 −1 1 −1 −1 1 1 |
| | −1 1 1 1 1 −1 1 −1 1 1 1 −1 −1 1 −1 −1 −1 −1 −1 1 1 1 1 1 1 1 1 1 −1 1 1 −1 1 1 1 |
| | 1 1 −1 1 1 −1 −1 −1 1 1 −1 1 −1 −1 1 −1 −1 −1 −1 1 1 1 1 1 −1 −1 −1 −1 1 1 −1 |
| | −1 −1 −1 1 −1 1 −1 −1 −1 −1 −1 1 −1 1 1 −1 −1 −1 1 −1 −1 1 1 1 −1 −1 1 −1 −1 1 |
| | −1 −1 −1 1 1 1 1 1 −1 1 1 1 −1 −1 −1 1 −1 1 −1 −1 −1 −1 −1 1 1 −1 1 1 −1 1 1 1 |
| | −1 1 −1 −1 1 −1 −1 −1 1 −1 −1 1 1 1 −1 −1 −1 1 −1 −1 −1 1 −1 −1 1 1 −1 −1 1 1 |
| | −1 1 1 1 −1 −1 1 1 1 1 1 −1 −1 −1 −1 −1 1 1 1 1 1 −1 1 −1 −1 1 −1 −1 1 −1 1 −1 1 |
| | 1 1 −1 −1 1 −1 1 −1 1 1 −1 −1 −1 −1 −1 1 −1 1 1 1 −1 −1 1 1 −1 −1 1 −1 1 1 1 1 |
| | −1 1 1 −1 −1 1 1 1 1 1 −1 −1 1 −1 1 −1 −1 −1 −1 −1 1 1 1 −1 1 1 1 −1 1 1 1 −1 1 |
| | −1 1 −1 1 1 1 1 1 −1 −1 −1 1 1 −1 −1 −1 1 −1 −1 −1 1 −1 −1 −1 −1 −1 1 1 −1 −1 |
| | −1 1 1 1 1 −1 1 −1 1 −1 1 −1 1 1 −1 −1 −1 −1 1 1 1 −1 −1 −1 1 1 −1 1 1 −1 1 1 −1 |
| | −1 −1 1 1 −1 1 1 1 1 1 −1 1 −1 −1 1 1 −1 −1 1 −1 1 −1 −1 −1 −1 1 1 −1 −1 1 −1 |
| | −1 −1 1 1 −1 1 −1 −1 1 −1 1 1 −1 −1 1 −1 1 −1 −1 −1 1 1 −1 1 1 −1 1 1 1 1 −1 −1 |
| | 1 1 1 −1 1 1 −1 1 −1 −1 1 1 −1 1 −1 −1 1 1 1 1 1 −1 1 −1 1 −1 1 −1 1 −1 1 −1 1 −1 |
| | −1 1 −1 −1 −1 1 −1 −1 −1 −1 1 1 −1 1 1 1 −1 −1 −1 1 1 1 −1 −1 1 −1 1 1 −1 1 −1 |
| | 1 1 1 1 −1 −1 1 −1 −1 1 −1 −1 −1 −1 −1 1 −1 1 1 1 −1 1 −1 1 1 −1 −1 −1 −1 1 1 |
| | −1 1 −1 1 1 −1 −1 −1 1 −1 −1 −1 1 −1 1 1 −1 1 1 −1 −1 1 −1 1 −1 −1 −1 −1 −1 −1 |
| | −1 1 1 1 −1 1 1 1 1 −1 1 −1 −1 −1 −1 −1 −1 1 −1 −1 −1 1 1 −1 1 −1 1 1 1 −1 −1 1 |
| | 1 −1 1 1 1 −1 −1 −1 −1 1 −1 1 1 −1 1 −1 −1 −1 −1 −1 1 −1 −1 −1 1 −1 −1 1 −1 −1 |
| | 1 −1 −1 1 −1 −1 −1 −1 1 1 1 −1 −1 −1 1 −1 1 1 −1 −1 −1 1 1 −1 −1 −1 −1 1 1 −1 1 |
| | −1 −1 −1 −1 1 −1 −1 −1 1 −1 1 1 −1 −1 −1 −1 1 1 1 1 1 −1 −1 1 1 1 −1 −1 1 −1 1 |
| | 1 −1 −1 1 1 −1 1 −1 −1 1 1 −1 1 −1 1 −1 1 −1 1 −1 −1 −1 −1 1 1 −1 1 1 1 1 1 −1 |
| | −1 1 −1 −1 1 1 −1 −1 −1 1 1 1 1 −1 −1 1 1 1 1 1 1 −1 −1 −1 1 1 −1 1 −1 −1 1 1 1 |
| | −1 1 1 −1 1 −1 1 −1 1 1 1 1 −1 −1 1 1 −1 −1 1 1 1 1 1 −1 −1 −1 1 1 1 −1 1 −1 1 1 |
| | 1 −1 1 −1 1 −1 −1 −1 −1 1 1 −1 −1 −1 1 −1 1 1 −1 −1 −1 −1 −1 −1 1 −1 1 1 −1 −1 |
| | 1 1 1 1 −1 −1 −1 1 1 1 1 −1 1 1 1 1 −1 1 −1 −1 1 1 −1 1 1 1 −1 1 1 1 −1 1 1 −1 1 |
| | 1 1 1 −1 1 1 −1 −1 1 −1 −1 1 −1 −1 1 1 1 1 −1 1 1 1 −1 −1 1 −1 1 1 −1 −1 −1 −1 |
| | −1 −1 −1 1 1 −1 −1 1 1 −1 1 1 1 1 1 1 −1 1 −1 1 1 −1 −1 1 1 −1 1 −1 1 −1 1 1 1 1 |
| | 1 1 1 −1 −1 1 1 −1 1 1 −1 1 1 −1 −1 1 −1 1 1 1 −1 1 −1 1 −1 −1 1 1 1 −1 −1 1 −1 |
| | −1 −1 1 −1 1 1 −1 1 −1 1 −1 −1 −1 −1 −1 1 −1 −1 1 1 1 1 −1 1 1 −1 1 −1 −1 −1 −1 |
| | 1 1 −1 −1 1 1 1 −1 −1 1 1 1 1 −1 1 1 −1 −1 −1 1 1 1 −1 −1 1 1 1 −1 1 −1 1 −1 −1 |
| | −1 1 1 −1 1 1 1 −1 1 −1 1 1 −1 −1 1 1 1 −1 −1 −1 −1 −1 1 −1 1 1 −1 −1 1 −1 −1 1 |
| | 1 −1 1 1 −1 1 1 1 −1 −1 1 −1 −1 −1 1 −1 −1 −1 −1 −1 −1 −1 −1 1 −1 −1 1 −1 1 −1 |
| | −1 1 −1 −1 −1 −1 −1 −1 −1 1 1 −1 −1 −1 −1 −1 −1 1 −1 1 −1 1 −1 −1 1 −1 1 1 −1 |
| | −1 −1 −1 −1 1 1 1 −1 −1 1 1 −1 −1 1 −1 −1 −1 1 −1 −1 −1 1 1 −1 1 −1 −1 −1 1 1 |
| | −1 −1 1 1 1 1 −1 1 1 −1 1 1 1 −1 1 1 −1 −1 1 1 1 −1 1 1 1 −1 1 −1 1 1 −1 1 −1 1 |
| | −1 −1 1 −1 1 −1 1 1 −1 −1 −1 1 1 1 1 1 −1 1 1 −1 1 −1 1 1 1 1 1 −1 −1 1 1 −1 1 1 |
| | 1 −1 1 1 −1 −1 −1 −1 1 1 1 −1 1 1 1 −1 −1 −1 1 1 1 1 1 1 1 1 −1 −1 −1 −1 1 −1 −1 |
| | −1 −1 1 1 1 1 1 1 1 −1 1 1 −1 −1 1 −1 −1 −1 1 −1 −1 1 −1 1 1 1 1 −1 1 1 1 1 1 −1 |
| | 1 −1 1 1 −1 1 1 −1 1 −1 1 −1 1 −1 1 −1 1 1 −1 −1 1 1 1 −1 1 1 −1 1 1 1 1 −1 −1 −1 |
| | −1 1 1 1 −1 −1 −1 −1 −1 −1 −1 1 1 1 −1 −1 −1 1 −1 −1 −1 −1 1 −1 −1 1 1 −1 −1 1 |
| | −1 −1 −1 −1 −1 1 1 −1 −1 1 −1 1 −1 1 1 1 1 1 −1 −1 1 −1 1 1 −1 1 1 1 −1 −1 −1 1 |
| | 1 −1 1 −1 −1 −1 −1 1 1 1 −1 −1 −1 −1 1 1 −1 −1 1 −1 −1 1 −1 1 1 1 1 −1 −1 −1 1 |
| | −1 1 1 1 1 1 1 1 −1 −1 −1 −1 −1 −1 1 1 1 −1 −1 −1 −1 1 −1 1 −1 −1 −1 1 1 1 1 1 |
| | −1 −1 1 −1 1 1 1 −1 1 −1 −1 1 −1 −1 1 −1 −1 1 1 −1 1 1 −1 −1 −1 1 1 −1 −1 −1 1 |
| | −1 1 1 1 1 −1 1 −1 1 1 1 1 1 1 1 −1 1 −1 1 1 1 −1 −1 −1 1 −1 1 −1 1 1 −1 1 1 −1 |
| | −1 −1 1 −1 −1 −1 −1 −1 −1 −1 1 −1 −1 1 1 1 1 1 −1 1 1 1 1 −1 1 −1 1 −1 1 1 1 −1 |
| | 1 1 1 1 −1 −1 1 1 −1 −1 −1 −1 1 −1 1 1 −1 1 1 1 −1 1 −1 −1 −1 1 −1 1 1 1 −1 −1 1 |
| | 1 1 1 1 1 1 −1 1 −1 −1 1 −1 1 1 1 −1 1 −1 −1 −1 1 −1 −1 −1 1 1 −1 −1 1 −1 1 1 −1 |
| | −1 1 1 1 −1 −1 1 1 −1 −1 −1 −1 1 1 −1 1 1 1 −1 1 1 1 −1 1 1 −1 −1 −1 1 −1 1 −1 |
| | −1 −1 1 −1 −1 −1 1 −1 −1 1 −1 1 −1 −1 1 1 1 −1 1 −1 1 −1 −1 1 −1 1 1 1 −1 1 1 1 |
| | −1 −1 −1 1 −1 −1 1 −1 1 −1 1 1 −1 −1 1 −1 1 −1 1 −1 −1 −1 1 −1 −1 1 −1 1 −1 1 |
| | −1 1 −1 −1 −1 −1 −1 −1 −1 −1 1 −1 1 −1 −1 −1 −1 1 1 −1 −1 1 1 1 −1 −1 1 1 1 |
| | −1 1 1 −1 −1 1 −1 −1 1 1 1 1 −1 1 −1 −1 −1 1 1 1 1 −1 −1 −1 1 1 1 −1 1 1 −1 1 −1 |
| | −1 −1 −1 −1 −1 −1 1 1 −1 1 1 −1 1 −1 −1 −1 −1 −1 1 1 1 −1 −1 −1 1 1 1 −1 1 1 1 |
| | −1 −1 1 −1 1 −1 1 −1 1 −1 1 −1 1 1 1 1 1 −1 1 1 1 −1 −1 1 −1 −1 −1 −1 1 −1 1 −1 |
| | 1 −1 1 −1 1 1 1 −1 −1 −1 −1 1 −1 −1 1 1 −1 1 1 1 1 1 1 1 −1 −1 −1 1 1 −1 −1 1 −1 |
| | −1 1 −1 −1 −1 1 −1 −1 1 −1 −1 −1 1 −1 −1 −1 1 −1 1 1 1 −1 1 1 −1 −1 −1 −1 −1 |
| | −1 1 1 1 −1 1 1 −1 −1 −1 −1 −1 1 −1 1 −1 −1 −1 1 1 −1 −1 1 1 −1 −1 −1 −1 1 1 1 |
| | −1 1 −1 −1 −1 1 −1 −1 1 −1 1 1 −1 −1 −1 −1 1 −1 1 −1 −1 1 1 −1 −1 −1 −1 1 1 −1 |
| | −1 −1 1 1 1 −1 1 1 1 1 1 1 1 1 1 1 1 1 −1 −1 1 −1 1 −1 1 −1 1 1 −1 −1 −1 1 −1 1 |
| | −1 −1 1 −1 −1 1 −1 −1 −1 1 1 −1 −1 1 1 1 −1 1 1 −1 −1 −1 1 −1 −1 1 −1 1 1 1 −1 |
| | 1 1 −1 1 −1 1 1 1 −1 −1 −1 1 1 −1 −1 −1 1 1 1 −1 −1 −1 1 −1 1 −1 1 −1 1 1 −1 −1 |
| | 1 −1 −1 −1 −1 1 1 1 −1 1 1 1 1 1 −1 −1 1 −1 1 −1 1 1 −1 1 1 −1 1 1 1 1 −1 1 −1 1 |
| | −1 −1 −1 1 1 1 −1 1 −1 −1 −1 −1 −1 1 −1 1 −1 −1 1 1 −1 1 1 −1 −1 1 1 −1 1 1 1 |
| | −1 1 −1 1 −1 1 −1 −1 1 −1 −1 1 −1 −1 1 −1 1 1 −1 −1 1 −1 −1 1 −1 1 1 −1 −1 −1 1 |
| | −1 −1 −1 −1 1 1 −1 −1 −1 1 1 −1 1 1 −1 1 −1 1 −1 1 1 −1 −1 −1 1 1 −1 −1 1 1 1 |
| | −1 −1 −1 −1 1 −1 −1 −1 1 1 −1 −1 −1 −1 −1 −1 1 1 −1 −1 −1 −1 1 1 1 1 1 1 1 1 −1 |
| | 1 1 −1 −1 −1 1 −1 1 1 1 −1 −1 −1 1 −1 −1 −1 −1 −1 1 −1 −1 1 1 −1 −1 −1 −1 1 1 1 |
| | 1 −1 −1 1 −1 −1 −1 1 1 −1 −1 −1 1 −1 1 −1 −1 1 1 1 1 1 −1 1 1 −1 −1 −1 −1 −1 −1 |
| | −1 −1 1 1 1 −1 −1 1 −1 −1 1 −1 1 1 1 −1 1 −1 1 1 1 1 −1 1 1 −1 −1 −1 −1 1 −1 1 1 |
| | −1 −1 −1 1 1 1 1 −1 1 1 −1 −1 −1 −1 −1 1 1 −1 −1 1 −1 −1 1 1 −1 1 −1 1 1 −1 1 1 |
| | −1 −1 −1 −1 1 −1 1 −1 1 −1 1 1 −1 1 −1 −1 1 −1 1 1 −1 1 −1 −1 −1 −1 1 −1 −1 1 |
| | −1 −1 −1 1 1 −1 1 −1 1 −1 −1 −1 1 1 −1 −1 −1 1 1 1 1 1 −1 −1 −1 −1 −1 −1 −1 1 |
| | −1 1 1 1 1 −1 1 1 1 −1 −1 −1 −1 −1 1 1 1 1 1 −1 1 1 1 1 1 −1 −1 −1 −1 −1 1 −1 |
| | −1 1 −1 −1 −1 −1 1 1 −1 1 −1 1 1 1 1 −1 −1 −1 1 −1 −1 −1 1 −1 1 −1 1 1 −1 −1 1 |
| | 1 1 1 −1 1 1 1 −1 1 −1 −1 −1 1 1 −1 1 −1 −1 1 1 −1 1 1 −1 −1 −1 −1 −1 −1 1 −1 |
| | −1 −1 −1 1 1 −1 1 −1 −1 −1 1 −1 −1 1 −1 −1 −1 −1 1 −1 1 1 1 1 −1 1 −1 −1 −1 1 |
| | −1 1 −1 1 1 1 −1 −1 −1 −1 −1 1 −1 −1 1 1 1 −1 1 1 −1 −1 −1 −1 1 −1 −1 −1 −1 1 |
| | −1 −1 1 −1 1 −1 −1 −1 1 −1 1 −1 1 −1 1 1 1 1 1 1 −1 1 −1 −1 1 1 1 −1 −1 1 −1 1 1 |
| | 1 1 1 −1 −1 −1 −1 1 1 1 1 −1 1 1 1 1 1 −1 −1 1 1 −1 −1 −1 1 1 1 −1 −1 1 −1 −1 −1 |
| | −1 −1 −1 −1 1 −1 1 −1 1 −1 1 −1 −1 −1 1 1 −1 1 −1 −1 −1 −1 −1 −1 1 1 −1 1 −1 |
| | −1 1 −1 1 −1 1 −1 −1 −1 −1 −1 1 −1 1 −1 1 −1 1 1 1 −1 −1 1 1 1 1 −1 −1 1 1 1 1 |
| | −1 −1 −1 1 −1 −1 1 1 1 −1 1 −1 −1 1 1 1 −1 1 1 1 −1 −1 −1 −1 −1 1 −1 1 −1 1 −1 |
| | −1 −1 1 1 −1 −1 1 −1 1 −1 −1 1 −1 −1 1 1 1 1 1 1 −1 −1 1 1 −1 1 −1 1 1 −1 |
| | −1 1 1 1 1 1 −1 1 −1 −1 −1 −1 1 −1 1 −1 1 −1 −1 1 1 −1 1 1 −1 1 −1 1 1 1 −1 1 1 1 |
| | −1 −1 1 −1 −1 1 1 1 1 1 1 1 1 1 −1 −1 −1 −1 −1 1 −1 1 −1 −1 1 −1 1 1 −1 −1 1 1 |
| | −1 −1 1 −1 −1 1 1 1 1 1 −1 −1 1 −1 −1 1 −1 1 −1 1 1 −1 1 −1 −1 −1 −1 −1 −1 1 −1 |
| | 1 1 1 −1 −1 −1 −1 −1 1 1 1 1 −1 1 1 1 −1 −1 −1 1 1 −1 −1 1 −1 1 −1 −1 1 −1 −1 |
| | −1 1 1 −1 1 1 −1 −1 1 −1 −1 1 1 −1 −1 −1 −1 −1 1 −1 −1 1 1 −1 1 1 −1 −1 1 −1 1 |
| | 1 −1 1 1 1 1 1 −1 −1 1 1 1 1 −1 −1 1 −1 −1 1 1 −1 1 1 1 −1 1 −1 −1 1 1 1 −1 −1 −1 |
| | 1 1 −1 1 −1 1 1 −1 −1 1 −1 −1 1 −1 −1 −1 −1 1 −1 −1 −1 1 −1 −1 −1 −1 1 −1 1 1 |
| | −1 1 1 −1 1 1 1 −1 1 1 1 1 1 −1 1 1 1 −1 1 −1 −1 1 −1 1 1 1 1 −1 −1 1 −1 −1 −1 1 |
| | −1 1 −1 1 1 1 1 1 −1 1 −1 −1 −1 1 1 1 −1 1 −1 1 1 −1 1 1 1 1 1 −1 1 −1 1 −1 1 1 |
| | −1 −1 −1 −1 −1 −1 1 1 −1 1 1 −1 −1 1 −1 1 −1 1 1 −1 1 −1 1 1 −1 1 −1 −1 −1 −1 1 |
| | 1 1 1 1 −1 1 1 −1 −1 1 1 −1 1 −1 1 1 −1 1 −1 1 −1 1 −1 −1 −1 −1 −1 1 1 −1 −1 −1 |
| | −1 −1 1 −1 −1 −1 −1 −1 −1 1 1 −1 −1 −1 1 −1 1 −1 1 −1 1 −1 1 −1 −1 −1 1 −1 1 1 |
| | 1 −1 1 −1 1 −1 1 −1 1 −1 −1 1 1 1 −1 −1 −1 1 −1 1 1 1 1 −1 −1 1 1 −1 1 −1 1 −1 1 |
| | −1 −1 1 −1 1 −1 −1 1 1 1 1 −1 −1 −1 −1 1 1 1 1 1 −1 1 −1 1 −1 −1 1 1 1 1 1 1 1 −1 |
| | 1 1 1 1 1 1 −1 1 1 1 −1 1 1 −1 −1 1 −1 −1 −1 −1 1 −1 −1 −1 −1 1 −1 1 −1 −1 −1 |
| | −1 1 −1 −1 −1 1 1 −1 1 1 −1 1 −1 −1 1 1 −1 −1 1 −1 −1 1 −1 1 −1 −1 1 1 −1 1 1 1 |
| | 1 1 −1 −1 −1 1 −1 −1 1 1 −1 1 1 1 −1 −1 1 −1 −1 1 −1 −1 1 −1 1 −1 1 −1 −1 −1 1 |
| | 1 1 1 1 1 1 1 1 1 −1 1 1 1 −1 1 −1 1 −1 −1 −1 1 −1 1 1 −1 1 1 1 1 1 1 1 1 −1 1 −1 |
| | −1 1 1 −1 1 −1 −1 −1 −1 1 −1 1 1 1 1 1 −1 −1 1 −1 −1 −1 −1 −1 1 −1 −1 1 −1 1 −1 |
| | 1 −1 −1 1 −1 1 −1 1 −1 1 −1 1 1 −1 1 −1 1 −1 −1 −1 1 1 1 1 −1 −1 1 −1 1 −1 −1 |
| | −1 1 1 1 −1 1 1 1 −1 1 −1 −1 −1 −1 −1 −1 −1 −1 1 1 −1 −1 1 −1 1 1 −1 1 −1 1 −1 |
| | −1 1 1 −1 −1 −1 1 1 −1 1 1 1 −1 −1 −1 −1 −1 1 1 −1 −1 −1 −1 1 −1 −1 1 −1 1 −1 1 |
| | 1 1 1 1 1 1 1 1 1 −1 −1 −1 1 1 1 1 1 1 −1 −1 −1 1 −1 1 1 1 −1 −1 1 −1 −1 1 −1 1 |
| | −1 −1 −1 −1 −1 −1 1 −1 1 −1 −1 −1 1 −1 1 −1 −1 1 1 −1 1 −1 1 −1 −1 1 1 1 −1 1 |
| | −1 −1 1 −1 −1 −1 −1 1 −1 −1 1 −1 −1 1 −1 1 1 1 1 1 1 −1 −1 −1 −1 1 −1 1 1 −1 −1 |
| | 1 −1 1 −1 1 1 1 −1 −1 −1 1 1 1 1 −1 −1 1 −1 −1 1 −1 1 1 −1 1 1 1 1 −1 1 −1 −1 1 |
| | −1 1 1 −1 1 1 1 −1 1 1 1 −1 −1 −1 −1 1 −1 −1 −1 −1 −1 −1 1 −1 1 −1 1 1 1 1 1 1 |
| | −1 −1 1 −1 −1 1 −1 −1 1 1 −1 −1 −1 −1 1 −1 −1 1 1 −1 −1 −1 1 −1 1 −1 1 1 −1 −1 |
| | −1 −1 1 −1 −1 −1 1 −1 −1 1 1 1 1 1 −1 −1 −1 1 −1 −1 −1 −1 −1 −1 1 −1 −1 1 1 −1 |
| | 1 −1 1 −1 −1 −1 −1 1 1 1 1 −1 −1 −1 −1 1 1 −1 −1 1 1 1 1 1 1 −1 1 −1 −1 −1 1 −1 |
| | 1 1 −1 1 −1 −1 1 −1 1 −1 1 1 1 −1 1 −1 −1 −1 −1 −1 1 1 −1 −1 1 1 −1 −1 −1 1 −1 |
| | 1 −1 −1 −1 −1 1 −1 1 1 1 −1 −1 −1 1 1 1 −1 1 −1 −1 −1 1 1 1 1 1 1 −1 −1 1 −1 −1 |
| | −1 1 −1 −1 1 1 −1 1 −1 1 1 1 −1 1 1 −1 1 −1 −1 −1 1 1 −1 1 1 −1 −1 −1 1 −1 −1 1 |
| | 1 −1 1 −1 −1 −1 1 1 1 −1 −1 −1 −1 −1 1 −1 −1 −1 −1 1 1 1 −1 −1 1 −1 −1 −1 1 1 |
| | −1 1 1 1 1 1 1 −1 −1 1 1 −1 −1 1 1 −1 −1 1 1 −1 1 1 −1 1 −1 −1 1 −1 1 −1 −1 −1 1 |
| | 1 1 1 −1 1 −1 −1 −1 −1 1 −1 −1 1 1 1 −1 −1 1 1 1 1 1 −1 1 1 −1 1 1 −1 1 −1 1 −1 |
| | −1 1 1 1 1 −1 −1 1 1 1 −1 1 −1 1 1 1 −1 −1 1 1 1 −1 1 −1 −1 1 −1 1 1 −1 −1 −1 1 1 |
| | 1 −1 1 1 −1 −1 1 −1 1 −1 1 −1 1 1 1 1 −1 −1 −1 −1 −1 1 1 −1 1 −1 1 −1 1 1 −1 1 |
| | −1 −1 −1 1 1 −1 −1 −1 −1 1 −1 −1 −1 1 1 1 1 −1 1 −1 1 1 −1 −1 −1 1 1 −1 1 −1 1 |
| | −1 −1 1 −1 1 1 −1 1 1 −1 1 1 −1 1 1 −1 1 −1 1 1 1 1 −1 1 −1 −1 1 1 1 −1 1 −1 −1 |
| | −1 1 −1 1 −1 −1 −1 1 1 −1 1 −1 1 1 −1 1 −1 −1 1 1 1 −1 1 −1 1 1 1 1 1 1 −1 1 1 1 |
| | 1 −1 1 1 −1 −1 −1 1 −1 −1 −1 1 1 −1 1 1 1 −1 −1 1 1 −1 −1 1 1 −1 1 −1 1 1 1 −1 |
| | −1 −1 −1 −1 −1 1 −1 −1 1 −1 −1 −1 1 −1 1 1 1 1 1 −1 1 1 1 1 1 1 1 −1 1 −1 −1 −1 |
| | 1 1 −1 1 1 1 1 −1 −1 −1 1 1 −1 −1 1 1 1 1 1 −1 1 1 1 −1 1 1 1 1 1 1 −1 1 −1 −1 −1 |
| | −1 1 1 −1 −1 −1 −1 1 1 −1 −1 1 −1 1 −1 −1 −1 1 −1 1 1 −1 −1 −1 1 −1 1 −1 1 −1 |
| | −1 1 1 1 −1 1 1 1 1 1 −1 1 −1 −1 −1 −1 −1 1 1 1 1 1 −1 −1 1 −1 −1 −1 1 1 1 1 −1 |
| | −1 −1 −1 −1 1 1 1 −1 −1 −1 −1 −1 1 1 1 −1 1 1 −1 1 1 −1 1 1 1 1 1 −1 −1 −1 −1 1 |
| | −1 −1 1 1 1 −1 1 −1 1 −1 1 −1 −1 −1 1 −1 −1 −1 1 1 1 1 1 1 1 −1 −1 1 1 1 −1 1 1 1 |
| | −1 −1 1 1 −1 −1 −1 −1 −1 −1 −1 −1 1 −1 −1 −1 1 1 1 −1 −1 −1 1 −1 −1 1 1 1 1 −1 |
| | −1 1 1 −1 1 1 1 1 −1 1 1 −1 1 −1 −1 1 1 1 −1 −1 1 1 −1 1 −1 1 −1 −1 1 −1 −1 −1 |
| | −1 −1 1 1 1 −1 −1 1 −1 1 −1 −1 −1 1 −1 −1 −1 −1 1 −1 −1 −1 −1 −1 1 1 1 −1 1 −1 |
| | −1 −1 −1 1 −1 −1 −1 −1 1 1 −1 −1 1 −1 1 1 1 −1 −1 −1 −1 1 1 −1 −1 −1 1 −1 −1 |
| | −1 −1 1 −1 1 −1 1 1 −1 −1 −1 1 −1 −1 1 −1 −1 −1 1 1 1 −1 −1 −1 −1 1 −1 −1 1 −1 |
| | 1 1 −1 1 −1 1 −1 1 −1 1 1 −1 1 1 −1 −1 1 −1 −1 1 −1 1 −1 1 −1 1 1 1 −1 1 −1 1 −1 |
| | 1 1 −1 −1 1 1 −1 1 1 −1 −1 −1 1 −1 1 −1 1 1 1 1 −1 1 1 1 −1 1 1 −1 1 −1 −1 1 −1 1 |
| | 1 1 −1 −1 1 −1 1 1 1 −1 1 1 1 1 1 −1 −1 −1 1 1 1 1 −1 −1 −1 1 −1 −1 −1 −1 1 1 1 1 |
| | −1 −1 1 1 1 −1 −1 1 1 −1 1 1 −1 −1 1 1 1 −1 1 −1 −1 −1 −1 −1 −1 1 1 1 −1 −1 1 1 |
| | 1 1 1 1 −1 1 1 1 −1 −1 −1 −1 1 1 1 −1 1 −1 1 1 1 1 −1 −1 −1 −1 1 −1 1 1 1 1 1 1 1 |
| | 1 1 −1 1 −1 1 1 −1 1 −1 1 1 1 1 1 1 1 1 −1 −1 −1 1 −1 −1 1 −1 1 1 −1 1 1 −1 −1 −1 |
| | −1 −1 1 1 1 1 1 1 −1 −1 1 1 1 −1 −1 −1 1 1 −1 −1 1 1 −1 −1 1 1 1 −1 1 1 1 1 −1 −1 |
| | −1 1 1 1 1 1 −1 1 −1 1 1 1 1 −1 1 −1 1 −1 1 −1 −1 −1 −1 1 −1 1 1 −1 1 −1 1 1 −1 1 |
| | 1 1 −1 1 1 −1 1 −1 1 −1 −1 −1 1 −1 −1 1 1 −1 −1 −1 −1 −1 −1 1 −1 −1 1 1 1 −1 −1 |
| | −1 −1 1 −1 1 1 1 −1 −1 1 −1 1 −1 −1 −1 −1 1 −1 1 −1 −1 −1 1 −1 −1 1 −1 −1 1 1 1 |
| | 1 1 −1 1 −1 −1 1 1 1 1 1 1 1 1 −1 1 −1 1 −1 1 1 1 1 −1 1 −1 1 1 −1 −1 1 −1 1 1 1 1 |
| | 1 1 −1 1 1 −1 −1 −1 −1 1 1 −1 1 1 −1 1 1 −1 1 1 1 −1 −1 −1 1 −1 1 1 1 −1 1 −1 −1 |
| | 1 1 1 1 1 −1 −1 1 1 1 1 1 1 1 1 −1 −1 1 1 1 1 −1 1 −1 −1 1 1 −1 −1 −1 1 1 1 −1 1 |
| | −1 −1 1 −1 1 −1 1 −1 1 1 −1 1 1 1 1 1 1 −1 −1 −1 −1 −1 1 1 −1 −1 1 1 1 1 −1 −1 |
| | −1 −1 −1 1 −1 −1 −1 1 −1 1 −1 −1 1 1 1 −1 −1 −1 −1 1 1 −1 1 −1 −1 1 1 1 1 −1 1 |
| | 1 1 1 1 1 1 1 −1 −1 1 −1 −1 1 1 1 1 −1 −1 1 −1 1 1 −1 1 −1 −1 −1 1 −1 −1 1 1 1 −1 |
| | 1 1 1 1 −1 1 1 1 −1 1 −1 1 1 1 −1 −1 −1 −1 1 1 1 1 −1 −1 −1 1 −1 1 1 −1 −1 1 −1 1 |
| | 1 −1 1 −1 −1 1 −1 −1 1 1 −1 1 1 1 1 −1 −1 1 1 −1 1 1 −1 −1 −1 −1 1 1 1 1 −1 1 −1 |
| | −1 1 −1 −1 1 1 −1 −1 −1 1 −1 −1 1 1 −1 −1 1 −1 1 1 −1 1 1 −1 −1 1 1 −1 −1 1 −1 |
| | 1 −1 1 −1 1 −1 −1 1 1 −1 1 −1 1 1 1 1 −1 1 1 1 1 −1 1 1 1 1 −1 −1 −1 1 −1 −1 1 −1 |
| | −1 −1 −1 −1 −1 1 1 −1 1 −1 −1 −1 −1 −1 1 −1 1 1 1 1 −1 −1 −1 1 1 −1 1 −1 1 −1 1 −1 |
| | −1 −1 1 1 1 −1 −1 1 −1 1 −1 1 1 1 1 −1 1 −1 −1 −1 −1 1 1 1 1 −1 1 1 −1 −1 1 1 −1 |
| | −1 1 1 −1 −1 −1 −1 −1 −1 1 1 1 1 −1 1 1 −1 1 −1 1 1 −1 −1 1 1 −1 −1 1 1 1 1 −1 1 |
| | −1 1 1 −1 1 1 1 −1 −1 −1 −1 −1 −1 −1 −1 1 −1 1 1 1 −1 1 1 −1 1 1 −1 1 −1 −1 1 |
| | −1 −1 1 −1 1 1 −1 1 −1 −1 1 1 1 1 −1 −1 −1 1 −1 1 −1 1 −1 −1 −1 −1 1 1 1 −1 1 |
| | −1 1 −1 −1 1 1 −1 1 −1 −1 −1 1 −1 −1 −1 1 −1 1 −1 −1 −1 −1 1 1 −1 1 −1 −1 1 −1 |
| | −1 1 1 1 −1 1 −1 1 1 −1 −1 1 −1 −1 −1 1 −1 1 −1 −1 −1 1 −1 1 1 1 1 |
| 6 | −1 −1 −1 −1 −1 −1 −1 −1 −1 −1 −1 −1 −1 1 −1 1 1 −1 −1 −1 1 −1 1 −1 1 −1 1 1 1 |
| | −1 1 1 1 −1 1 −1 −1 −1 −1 −1 1 −1 −1 1 −1 −1 −1 −1 1 −1 −1 −1 1 −1 1 1 1 1 −1 |
| | −1 −1 −1 −1 1 1 −1 1 1 1 −1 1 1 −1 1 −1 1 1 −1 1 −1 1 1 −1 −1 1 1 −1 −1 −1 −1 |
| | −1 1 −1 −1 −1 −1 1 1 1 1 1 −1 −1 −1 −1 1 1 1 −1 −1 −1 −1 −1 −1 1 1 1 −1 1 −1 −1 |
| | −1 1 −1 −1 1 1 1 1 −1 −1 1 1 −1 −1 −1 −1 −1 1 1 1 1 −1 −1 1 1 −1 −1 1 1 1 1 −1 1 |
| | 1 1 1 −1 −1 1 1 −1 1 1 −1 1 1 1 −1 −1 1 −1 1 1 −1 −1 −1 −1 −1 −1 1 −1 −1 −1 1 1 |
| | 1 1 1 1 −1 −1 −1 −1 −1 −1 −1 1 −1 1 −1 −1 1 −1 1 1 −1 1 1 1 −1 −1 −1 1 1 −1 −1 |
| | −1 1 1 1 −1 1 −1 −1 −1 −1 −1 −1 −1 −1 −1 1 1 −1 1 1 −1 −1 −1 1 −1 −1 1 −1 1 1 |
| | −1 1 −1 −1 −1 1 −1 1 −1 1 1 −1 1 1 1 −1 −1 1 1 1 1 1 1 1 −1 1 −1 1 −1 −1 −1 1 −1 |
| | 1 −1 1 −1 −1 1 −1 −1 1 −1 −1 1 1 1 1 1 1 1 1 1 −1 1 −1 −1 −1 1 −1 1 1 1 1 1 |
| | 1 −1 1 −1 1 −1 1 −1 1 1 −1 1 1 1 −1 1 −1 −1 1 −1 1 1 −1 1 −1 1 −1 1 1 −1 1 1 −1 |
| | −1 1 1 1 −1 −1 −1 1 −1 1 −1 1 −1 −1 1 1 1 −1 −1 1 1 1 −1 −1 −1 −1 −1 −1 −1 1 1 |
| | 1 −1 1 −1 1 1 −1 −1 1 1 1 −1 −1 1 1 −1 −1 1 −1 −1 1 1 1 1 −1 −1 1 −1 1 1 −1 1 −1 |
| | 1 −1 −1 −1 1 1 −1 −1 −1 −1 −1 −1 1 1 1 −1 −1 1 1 −1 −1 −1 −1 −1 −1 −1 −1 1 1 |
| | −1 1 −1 1 1 −1 −1 −1 −1 −1 1 −1 −1 1 −1 1 −1 −1 −1 1 1 −1 −1 −1 1 1 1 1 −1 1 −1 |
| | 1 −1 −1 1 1 1 1 −1 −1 1 1 1 1 1 −1 1 1 1 −1 −1 1 1 −1 −1 1 −1 1 −1 −1 1 −1 −1 −1 |
| | −1 1 −1 −1 1 −1 1 1 −1 1 1 1 1 1 1 1 −1 −1 −1 1 −1 −1 −1 1 −1 1 −1 −1 1 1 −1 −1 |
| | 1 1 −1 1 −1 1 1 1 1 −1 −1 1 −1 1 −1 −1 −1 −1 1 1 1 1 1 −1 1 1 1 1 −1 1 −1 1 1 1 1 |
| | 1 −1 −1 1 −1 −1 1 −1 −1 −1 1 1 1 1 1 1 1 1 1 −1 1 −1 −1 −1 1 −1 1 1 −1 1 1 1 1 −1 |
| | 1 1 1 1 1 1 1 −1 −1 1 −1 1 −1 1 1 −1 −1 1 1 −1 −1 1 1 1 1 1 −1 −1 1 −1 −1 −1 −1 |
| | −1 1 −1 −1 1 −1 1 1 1 1 1 −1 −1 −1 1 −1 −1 −1 −1 1 −1 −1 1 1 1 1 1 −1 −1 1 −1 1 |
| | 1 1 −1 −1 −1 −1 −1 1 −1 −1 −1 −1 −1 −1 −1 1 −1 −1 −1 1 1 −1 −1 −1 1 1 −1 −1 1 |
| | 1 1 1 −1 1 −1 −1 −1 −1 1 1 1 1 −1 −1 1 −1 −1 −1 −1 −1 −1 1 1 1 1 1 1 −1 −1 −1 1 |
| | 1 1 −1 −1 −1 1 1 1 −1 1 −1 −1 1 1 1 −1 1 −1 −1 −1 −1 1 −1 −1 1 1 −1 1 1 1 1 −1 |
| | −1 −1 1 1 −1 −1 −1 −1 1 1 1 −1 1 −1 1 −1 −1 −1 −1 −1 −1 −1 1 1 1 −1 −1 1 −1 1 1 |
| | −1 1 −1 −1 1 1 −1 −1 1 −1 1 1 1 1 1 −1 −1 1 −1 1 −1 1 −1 1 1 1 −1 −1 −1 −1 −1 |
| | −1 −1 −1 1 1 1 −1 1 1 −1 −1 −1 1 1 1 −1 1 1 −1 −1 1 1 1 −1 1 −1 1 1 −1 1 1 1 −1 1 |
| | 1 1 −1 −1 −1 1 −1 −1 1 −1 1 −1 −1 1 1 1 1 1 1 1 −1 1 1 −1 1 −1 1 1 −1 −1 1 −1 1 1 |
| | −1 1 −1 1 1 1 1 1 −1 −1 −1 1 1 1 1 −1 −1 −1 −1 −1 −1 −1 −1 −1 1 1 1 −1 −1 −1 1 |
| | −1 1 1 1 −1 1 −1 −1 1 1 −1 1 1 1 −1 −1 1 −1 1 −1 1 1 −1 1 −1 −1 −1 1 1 1 −1 −1 |
| | −1 1 1 −1 1 −1 −1 1 1 1 −1 1 −1 1 1 1 1 1 −1 1 −1 1 −1 −1 −1 −1 1 −1 −1 −1 −1 |
| | −1 −1 1 1 −1 1 1 −1 1 1 −1 −1 1 1 −1 −1 −1 1 −1 1 1 1 1 −1 −1 1 1 1 1 −1 −1 1 −1 |
| | −1 1 −1 −1 1 −1 −1 1 −1 1 1 −1 −1 −1 1 −1 1 1 −1 1 1 −1 1 −1 −1 −1 −1 1 −1 1 1 |
| | −1 −1 1 −1 −1 −1 −1 1 1 −1 −1 1 −1 1 1 1 1 −1 1 1 1 1 1 −1 −1 1 −1 −1 −1 1 1 −1 |
| | −1 1 1 −1 −1 −1 −1 −1 −1 1 1 −1 1 1 1 −1 −1 −1 1 1 1 1 1 1 −1 1 −1 −1 1 1 1 1 1 1 |
| | −1 −1 1 −1 1 −1 −1 −1 1 −1 −1 1 −1 1 −1 −1 −1 −1 −1 1 −1 1 1 1 −1 −1 1 −1 1 −1 |
| | 1 −1 1 −1 −1 1 −1 1 −1 −1 1 1 1 −1 −1 −1 1 1 1 1 1 −1 1 −1 −1 1 1 1 −1 −1 −1 −1 |
| | 1 1 −1 −1 1 1 1 −1 1 1 1 −1 −1 1 −1 −1 1 1 −1 −1 1 1 1 1 1 1 1 −1 −1 1 −1 −1 1 −1 |
| | 1 1 −1 1 −1 1 1 −1 −1 −1 −1 1 −1 1 −1 −1 −1 1 1 1 1 −1 −1 1 1 −1 1 −1 −1 1 −1 |
| | −1 1 −1 −1 −1 1 1 −1 −1 −1 1 −1 1 1 1 −1 1 1 1 −1 1 1 1 1 −1 1 1 −1 1 −1 1 1 1 1 |
| | −1 −1 −1 1 −1 −1 1 −1 −1 −1 −1 −1 −1 −1 1 −1 1 1 −1 1 1 −1 −1 −1 −1 1 1 −1 −1 |
| | −1 1 −1 −1 1 −1 −1 1 −1 −1 1 1 −1 −1 −1 1 −1 1 1 −1 −1 1 −1 −1 1 1 −1 1 1 −1 1 |
| | 1 −1 −1 −1 −1 1 −1 1 1 −1 −1 −1 −1 −1 1 1 −1 1 1 −1 1 −1 1 1 1 −1 −1 −1 1 −1 1 |
| | −1 −1 −1 −1 −1 −1 −1 −1 1 1 1 1 −1 −1 −1 1 −1 1 −1 −1 1 −1 −1 1 1 1 1 −1 1 1 −1 |
| | −1 −1 1 1 1 1 −1 −1 −1 1 1 1 −1 1 −1 1 −1 −1 1 1 1 −1 1 1 1 −1 1 1 −1 1 −1 −1 −1 |
| | 1 1 1 1 1 1 1 −1 −1 1 1 1 −1 −1 −1 1 −1 −1 1 −1 −1 1 1 1 −1 1 1 −1 −1 −1 1 −1 −1 |
| | 1 1 −1 −1 −1 −1 −1 −1 1 −1 1 −1 1 −1 −1 −1 1 −1 −1 −1 −1 −1 −1 −1 1 1 1 1 1 −1 |
| | −1 −1 1 −1 −1 1 1 −1 −1 1 1 1 −1 −1 −1 1 1 −1 1 1 1 −1 1 −1 −1 1 1 −1 −1 −1 −1 |
| | −1 1 1 −1 −1 1 −1 −1 1 −1 1 −1 −1 −1 −1 1 −1 1 1 −1 1 −1 1 −1 1 −1 1 −1 1 1 −1 |
| | 1 −1 −1 1 1 1 −1 1 1 −1 −1 1 −1 1 −1 −1 1 −1 1 1 1 1 1 −1 1 1 −1 −1 1 −1 −1 −1 1 |
| | 1 −1 −1 −1 −1 1 −1 1 −1 −1 1 −1 −1 1 −1 −1 −1 −1 −1 1 −1 1 1 −1 −1 −1 −1 1 −1 |
| | −1 −1 −1 1 −1 −1 1 −1 −1 −1 1 1 −1 1 1 −1 −1 −1 1 1 1 −1 −1 −1 1 −1 −1 1 1 1 −1 |
| | 1 −1 −1 1 −1 1 1 1 −1 1 1 1 1 1 1 −1 −1 1 1 −1 −1 1 −1 1 1 1 −1 −1 1 −1 −1 −1 1 1 |
| | −1 1 −1 −1 −1 1 −1 −1 1 1 −1 −1 1 −1 −1 1 −1 1 1 1 1 −1 −1 −1 1 −1 1 −1 1 −1 1 |
| | −1 −1 1 1 −1 1 −1 −1 1 1 1 1 1 −1 −1 −1 −1 1 −1 −1 1 −1 1 −1 −1 1 −1 −1 −1 1 −1 |
| | 1 −1 −1 −1 1 −1 1 −1 −1 −1 −1 −1 1 1 1 1 −1 1 1 1 1 1 −1 1 −1 1 −1 1 1 1 1 1 −1 |
| | −1 1 1 1 −1 −1 1 −1 1 −1 −1 −1 −1 −1 −1 −1 1 −1 −1 1 −1 −1 −1 1 −1 1 −1 1 1 −1 |
| | −1 −1 −1 −1 1 1 1 −1 −1 −1 −1 −1 1 −1 −1 1 1 1 −1 1 1 −1 1 1 −1 −1 1 1 1 1 1 1 1 |
| | 1 1 −1 −1 1 1 −1 −1 −1 1 −1 1 −1 −1 −1 −1 1 1 1 −1 −1 1 1 −1 1 1 1 −1 1 −1 −1 |
| | −1 −1 1 −1 1 −1 −1 −1 −1 1 1 −1 1 1 1 −1 −1 1 −1 −1 1 −1 1 1 1 −1 1 1 −1 −1 −1 |
| | 1 1 −1 1 −1 1 1 −1 1 −1 −1 1 −1 1 −1 −1 −1 1 −1 −1 −1 1 −1 −1 1 −1 −1 1 −1 1 −1 |
| | −1 −1 1 −1 1 1 −1 −1 1 1 −1 1 −1 1 −1 1 1 1 1 −1 −1 −1 −1 −1 −1 −1 1 1 −1 1 −1 |
| | −1 −1 1 −1 1 −1 −1 −1 1 1 −1 1 −1 1 −1 −1 −1 −1 −1 −1 1 −1 −1 1 1 −1 1 1 −1 −1 |
| | 1 −1 1 1 1 1 1 1 1 −1 −1 −1 −1 1 1 −1 −1 −1 1 1 1 −1 −1 1 1 −1 1 −1 −1 1 1 1 −1 |
| | −1 1 −1 1 −1 1 1 1 −1 1 −1 1 1 1 −1 1 1 1 −1 −1 1 1 −1 1 −1 1 1 1 −1 1 1 1 1 1 −1 |
| | 1 1 1 −1 −1 −1 −1 1 −1 −1 −1 1 1 1 −1 1 1 1 1 1 −1 1 −1 −1 1 −1 1 −1 1 1 1 1 −1 |
| | −1 −1 1 1 1 −1 −1 1 −1 −1 1 1 1 −1 1 −1 −1 −1 1 −1 1 −1 −1 1 −1 −1 −1 −1 −1 1 1 |
| | 1 1 1 1 1 −1 −1 −1 −1 −1 −1 1 −1 1 1 1 −1 1 1 −1 −1 1 −1 −1 −1 −1 −1 1 −1 1 −1 |
| | 1 1 −1 1 1 −1 1 1 1 −1 1 1 −1 −1 −1 1 −1 1 −1 −1 −1 1 −1 −1 1 1 −1 1 −1 1 −1 −1 |
| | −1 1 −1 −1 −1 1 1 1 −1 −1 1 1 −1 −1 1 1 1 −1 1 −1 1 −1 1 −1 1 −1 −1 1 −1 −1 1 1 |
| | 1 −1 1 −1 1 1 −1 −1 −1 −1 −1 −1 1 1 1 1 1 −1 1 1 −1 −1 1 1 1 1 1 −1 1 1 1 −1 |
| | 1 −1 1 1 1 −1 1 −1 −1 −1 1 1 1 1 −1 1 1 1 1 −1 1 −1 −1 −1 −1 1 −1 −1 −1 −1 1 1 |
| | −1 1 1 1 1 1 −1 −1 1 1 −1 −1 −1 −1 1 −1 −1 1 −1 −1 −1 −1 −1 1 1 −1 −1 −1 1 −1 |
| | −1 −1 1 1 1 1 −1 1 −1 1 1 1 −1 1 −1 1 −1 1 −1 −1 −1 −1 −1 1 1 1 −1 1 −1 1 −1 1 1 |
| | 1 −1 1 −1 1 −1 −1 1 1 −1 1 −1 1 −1 −1 1 −1 1 −1 1 1 1 −1 1 1 −1 −1 1 1 1 1 −1 1 1 |
| | −1 −1 1 −1 −1 1 −1 −1 −1 1 −1 −1 −1 1 −1 1 1 −1 1 −1 1 1 1 −1 −1 1 −1 1 1 1 −1 |
| | −1 1 1 1 1 1 −1 −1 1 1 1 1 −1 1 1 −1 1 −1 1 −1 −1 −1 −1 1 −1 1 1 1 −1 1 1 1 1 −1 |
| | −1 1 −1 −1 1 −1 1 −1 1 −1 −1 −1 1 −1 1 1 1 −1 1 −1 1 −1 −1 −1 −1 1 1 1 1 −1 1 |
| | −1 1 −1 1 −1 −1 1 −1 −1 −1 −1 −1 −1 −1 −1 1 −1 1 1 1 1 1 1 1 1 −1 −1 1 −1 −1 −1 |
| | 1 −1 1 1 1 −1 −1 −1 1 1 1 1 −1 −1 1 1 1 −1 1 −1 −1 −1 −1 −1 1 1 1 −1 −1 1 −1 −1 |
| | −1 1 1 1 −1 1 −1 1 1 −1 1 −1 −1 1 1 −1 1 −1 1 1 −1 1 1 −1 1 1 −1 1 −1 1 1 −1 −1 |
| | −1 1 −1 1 1 1 −1 −1 −1 −1 −1 −1 1 1 −1 1 −1 −1 1 −1 1 1 1 −1 −1 −1 −1 1 −1 1 −1 |
| | 1 −1 −1 1 1 −1 1 1 1 −1 1 −1 1 1 1 1 1 1 −1 1 1 1 −1 −1 1 −1 1 1 1 1 1 −1 1 −1 1 1 |
| | 1 1 −1 −1 −1 −1 1 1 1 1 −1 −1 1 1 1 1 −1 1 −1 1 −1 −1 −1 −1 −1 1 1 −1 1 −1 −1 |
| | −1 −1 1 −1 −1 1 −1 1 −1 1 −1 1 −1 1 1 −1 −1 1 1 1 −1 1 −1 −1 −1 1 1 −1 1 −1 −1 |
| | −1 −1 1 1 1 −1 −1 −1 −1 1 1 −1 1 −1 −1 1 1 1 1 −1 1 1 −1 1 1 −1 1 −1 1 −1 1 1 −1 |
| | −1 −1 1 −1 −1 1 1 1 1 1 −1 1 −1 1 1 −1 1 −1 1 1 1 1 −1 1 1 −1 −1 1 1 −1 1 1 1 1 1 |
| | 1 −1 −1 1 −1 1 1 1 1 1 1 −1 1 1 −1 1 1 1 1 1 1 −1 −1 −1 1 −1 1 −1 1 1 −1 1 −1 −1 |
| | 1 −1 −1 1 1 −1 −1 −1 −1 1 −1 1 1 −1 1 1 1 −1 −1 1 −1 −1 −1 1 −1 1 −1 −1 1 −1 1 |
| | 1 1 −1 −1 1 1 −1 −1 −1 −1 1 1 1 −1 −1 1 −1 −1 1 −1 −1 1 1 1 −1 −1 −1 1 −1 1 1 |
| | −1 1 −1 −1 1 1 1 1 −1 −1 −1 1 1 −1 −1 1 1 −1 1 −1 −1 1 1 −1 1 1 1 1 1 −1 −1 −1 |
| | −1 1 −1 1 −1 1 1 1 −1 1 1 1 1 −1 1 −1 1 −1 −1 −1 1 1 −1 1 1 1 −1 1 1 1 −1 1 1 −1 |
| | −1 1 1 −1 −1 1 1 −1 −1 −1 −1 1 1 −1 1 1 1 1 −1 1 1 1 −1 −1 −1 1 1 −1 1 1 −1 1 −1 |
| | −1 1 1 1 1 1 1 1 1 −1 −1 −1 −1 −1 1 −1 1 1 −1 1 −1 −1 −1 1 1 −1 1 1 −1 −1 1 −1 |
| | −1 1 1 −1 −1 −1 1 1 −1 −1 −1 1 1 −1 1 −1 −1 1 −1 −1 1 1 1 1 1 −1 −1 −1 1 −1 1 |
| | −1 −1 −1 1 1 1 −1 1 1 1 −1 −1 1 1 1 −1 1 1 −1 1 −1 −1 −1 −1 −1 −1 1 −1 1 1 1 1 |
| | −1 −1 −1 1 1 −1 1 1 1 1 −1 1 −1 −1 1 −1 1 1 1 1 −1 −1 1 −1 1 1 1 1 −1 −1 1 1 −1 |
| | −1 1 −1 −1 −1 −1 −1 1 1 −1 1 1 −1 −1 1 −1 1 −1 −1 −1 1 −1 1 −1 1 1 1 −1 −1 1 1 |
| | −1 1 −1 −1 −1 −1 −1 −1 1 1 −1 −1 1 −1 −1 −1 1 −1 −1 1 −1 −1 −1 1 −1 −1 1 −1 1 |
| | 1 −1 −1 1 1 −1 −1 −1 1 1 −1 −1 1 −1 −1 −1 −1 −1 −1 −1 1 1 −1 −1 −1 −1 1 −1 1 1 |
| | 1 −1 −1 1 1 −1 1 1 1 1 −1 1 −1 1 −1 1 1 −1 1 1 1 1 −1 1 −1 −1 −1 1 −1 1 −1 1 −1 1 |
| | −1 1 −1 −1 −1 −1 −1 −1 −1 −1 −1 −1 −1 1 1 −1 −1 −1 1 −1 1 1 −1 1 −1 1 −1 −1 1 |
| | −1 −1 −1 1 −1 −1 1 1 −1 −1 −1 1 1 1 1 1 1 −1 −1 1 1 1 −1 1 1 −1 −1 1 1 −1 1 −1 |
| | −1 −1 1 −1 −1 −1 −1 1 −1 −1 −1 −1 −1 1 −1 −1 −1 −1 1 −1 −1 −1 1 1 −1 −1 1 −1 |
| | −1 −1 1 1 1 −1 −1 1 −1 1 1 1 −1 1 −1 −1 1 −1 1 −1 1 −1 −1 −1 −1 1 −1 1 −1 −1 1 |
| | 1 −1 1 1 1 1 −1 1 1 −1 1 1 −1 −1 1 −1 −1 −1 1 −1 1 1 −1 1 1 −1 −1 1 1 −1 1 1 −1 |
| | −1 −1 1 1 −1 1 1 −1 −1 −1 −1 −1 −1 −1 1 −1 1 1 1 −1 −1 −1 1 −1 −1 −1 −1 1 1 1 |
| | −1 1 −1 1 1 1 1 −1 1 −1 −1 −1 −1 −1 1 1 −1 1 1 1 1 −1 −1 −1 −1 −1 1 −1 1 −1 1 |
| | −1 −1 1 −1 1 −1 1 −1 −1 1 1 −1 −1 −1 −1 −1 −1 −1 1 −1 −1 −1 −1 −1 1 −1 1 1 1 1 |
| | 1 −1 −1 −1 −1 1 1 −1 1 1 −1 1 −1 −1 −1 −1 −1 1 −1 1 1 −1 1 1 1 1 1 −1 −1 1 −1 1 |
| | 1 −1 1 1 −1 1 −1 1 1 1 1 1 1 1 1 1 −1 1 1 1 1 1 1 1 1 1 −1 −1 −1 −1 1 −1 1 1 −1 −1 |
| | 1 1 1 1 −1 −1 1 −1 1 −1 1 −1 −1 −1 −1 −1 1 −1 −1 1 1 1 1 −1 −1 −1 −1 1 −1 1 −1 |
| | −1 −1 −1 −1 −1 1 1 −1 1 −1 1 −1 1 1 −1 1 −1 1 1 1 −1 1 −1 1 1 −1 1 −1 1 −1 −1 |
| | −1 −1 −1 1 −1 1 −1 −1 1 −1 −1 −1 1 1 −1 1 −1 1 1 −1 −1 1 1 1 1 1 −1 1 1 −1 1 1 1 |
| | −1 −1 −1 −1 1 −1 1 1 −1 1 −1 −1 1 −1 −1 −1 −1 1 −1 1 −1 1 1 −1 −1 1 −1 −1 −1 |
| | −1 −1 −1 1 −1 −1 −1 1 −1 −1 −1 1 −1 −1 −1 1 1 1 1 1 −1 1 1 −1 1 −1 −1 1 −1 1 −1 |
| | 1 1 −1 −1 1 −1 1 1 1 −1 1 1 −1 1 1 −1 1 1 1 −1 −1 −1 1 −1 1 1 −1 −1 1 1 1 −1 1 1 |
| | 1 1 1 −1 −1 1 1 1 1 1 −1 −1 −1 −1 −1 1 1 1 1 1 −1 1 −1 1 1 1 −1 1 1 −1 1 1 1 −1 |
| | −1 1 1 −1 −1 −1 1 −1 −1 1 1 −1 1 1 1 −1 1 1 −1 −1 1 −1 1 1 1 −1 −1 −1 1 1 −1 −1 |
| | 1 −1 −1 1 1 1 −1 1 1 1 1 1 1 1 −1 1 −1 1 1 1 1 1 1 1 −1 −1 1 1 −1 1 1 −1 −1 −1 −1 |
| | −1 1 1 −1 −1 −1 1 1 1 1 1 −1 1 1 1 −1 1 −1 −1 −1 1 1 −1 −1 1 1 −1 1 1 1 −1 1 1 1 |
| | 1 −1 −1 −1 1 1 1 1 1 −1 −1 1 1 1 −1 1 −1 1 1 1 −1 −1 1 1 1 1 −1 1 1 1 −1 1 1 1 −1 |
| | −1 1 −1 1 −1 −1 −1 1 1 1 −1 −1 −1 −1 −1 1 1 1 −1 1 −1 −1 1 −1 1 −1 −1 1 1 −1 1 |
| | 1 −1 −1 1 1 −1 −1 1 −1 1 1 −1 1 1 1 1 −1 −1 −1 −1 1 −1 1 1 1 1 −1 1 −1 1 −1 1 −1 |
| | 1 −1 1 −1 1 −1 −1 1 1 1 −1 1 −1 −1 1 1 −1 −1 1 1 1 1 −1 −1 −1 −1 1 1 −1 1 −1 1 |
| | −1 −1 1 −1 −1 1 −1 1 −1 −1 1 −1 1 1 −1 −1 −1 −1 −1 1 −1 1 −1 1 1 1 −1 −1 −1 −1 |
| | 1 1 1 −1 −1 1 1 1 −1 −1 1 1 1 −1 1 1 1 −1 1 −1 1 −1 −1 1 −1 1 −1 −1 −1 −1 −1 −1 |
| | 1 −1 1 −1 −1 −1 −1 1 −1 1 −1 1 −1 −1 −1 −1 1 1 −1 1 −1 −1 1 −1 −1 −1 −1 −1 1 |
| | −1 −1 −1 1 −1 1 −1 1 1 1 1 1 −1 1 1 1 −1 1 1 1 1 1 −1 −1 −1 −1 −1 1 −1 −1 −1 1 1 |
| | 1 −1 −1 −1 −1 1 −1 −1 1 1 1 −1 1 −1 1 −1 1 1 −1 1 −1 −1 −1 −1 −1 −1 −1 1 −1 1 |
| | −1 1 −1 1 1 −1 −1 1 −1 −1 1 1 1 −1 −1 −1 −1 1 −1 1 1 1 −1 1 −1 −1 −1 −1 1 1 −1 |
| | 1 −1 1 −1 1 −1 1 −1 −1 −1 1 1 1 −1 1 −1 −1 1 −1 −1 1 1 1 −1 −1 1 −1 1 1 −1 −1 1 |
| | 1 1 −1 −1 −1 −1 1 −1 −1 −1 −1 −1 −1 −1 −1 1 1 −1 −1 1 −1 1 1 −1 −1 1 1 −1 1 1 |
| | −1 1 1 −1 1 1 1 1 1 1 1 1 1 1 1 1 −1 −1 −1 1 −1 1 1 −1 −1 −1 −1 −1 −1 −1 1 1 −1 |
| | −1 1 1 −1 −1 −1 1 1 1 1 −1 −1 1 −1 −1 1 1 1 −1 −1 1 1 −1 −1 −1 1 1 1 −1 1 1 1 1 |
| | −1 1 −1 −1 1 1 −1 −1 1 −1 −1 −1 −1 1 −1 −1 −1 −1 1 −1 1 −1 1 −1 1 1 1 1 −1 −1 1 |
| | 1 1 −1 1 1 1 1 −1 1 1 1 −1 1 1 −1 1 1 1 1 1 −1 1 1 −1 −1 −1 1 1 −1 −1 1 −1 1 1 1 |
| | −1 1 −1 1 −1 1 1 1 1 −1 1 1 1 −1 1 −1 1 −1 1 −1 1 1 1 −1 −1 1 1 1 −1 1 −1 1 −1 −1 |
| | 1 −1 −1 1 1 −1 1 −1 −1 −1 1 −1 1 1 1 1 1 −1 −1 1 1 −1 1 1 1 1 1 −1 1 1 1 1 1 1 −1 |
| | −1 −1 −1 1 −1 −1 −1 1 −1 −1 1 1 −1 1 1 −1 1 −1 1 1 −1 1 1 −1 −1 −1 1 1 1 1 1 1 1 |
| | 1 −1 1 −1 −1 1 −1 1 1 −1 −1 1 −1 −1 −1 1 −1 −1 −1 1 1 −1 −1 −1 −1 −1 1 −1 −1 1 |
| | 1 −1 1 −1 1 1 1 1 1 1 −1 −1 −1 −1 −1 1 1 −1 −1 −1 −1 −1 −1 1 −1 −1 1 −1 −1 1 −1 |
| | 1 1 1 1 1 1 1 1 1 1 −1 −1 1 −1 1 1 −1 −1 −1 1 1 1 1 1 −1 −1 −1 −1 −1 −1 −1 −1 1 |
| | −1 −1 1 1 −1 −1 −1 1 −1 −1 −1 1 −1 −1 −1 −1 −1 −1 1 −1 −1 1 −1 1 −1 1 1 −1 1 1 |
| | −1 −1 −1 −1 −1 −1 1 −1 1 1 −1 1 −1 1 1 −1 1 1 1 1 1 1 −1 1 1 −1 −1 −1 −1 1 −1 1 |
| | −1 1 1 −1 1 −1 1 −1 1 −1 −1 1 −1 1 1 1 −1 1 −1 −1 −1 1 −1 −1 −1 −1 −1 1 1 −1 1 |
| | −1 1 1 1 1 1 −1 1 1 −1 1 −1 1 −1 1 1 1 1 1 1 1 −1 1 −1 −1 −1 −1 1 −1 1 1 1 1 −1 |
| | −1 1 −1 −1 −1 −1 1 1 −1 1 −1 1 1 −1 1 1 1 −1 −1 −1 −1 −1 1 −1 1 1 1 −1 1 −1 1 1 |
| | 1 1 −1 −1 1 1 −1 1 −1 1 −1 1 −1 −1 −1 −1 1 −1 −1 1 1 1 −1 −1 1 −1 −1 −1 1 −1 −1 |
| | 1 1 1 1 1 1 −1 1 1 −1 −1 1 1 −1 −1 −1 −1 1 −1 1 −1 1 −1 1 −1 −1 −1 −1 1 1 1 −1 1 |
| | −1 −1 −1 −1 1 1 1 −1 1 1 1 1 −1 −1 1 1 1 −1 −1 −1 −1 1 1 1 1 −1 1 −1 −1 1 −1 −1 |
| | 1 1 −1 1 1 1 1 1 1 1 1 −1 −1 −1 1 1 −1 −1 −1 1 −1 −1 1 1 1 −1 −1 1 1 1 1 1 1 −1 1 |
| | −1 −1 −1 −1 −1 1 −1 1 −1 1 −1 1 −1 1 1 1 1 −1 1 −1 −1 1 1 1 1 −1 −1 1 −1 −1 −1 |
| | 1 1 1 1 −1 1 1 −1 −1 1 1 1 −1 −1 1 −1 1 1 1 1 −1 1 −1 −1 −1 1 1 −1 1 1 1 1 −1 −1 |
| | 1 1 1 1 1 1 −1 −1 1 1 −1 1 −1 1 1 −1 1 −1 1 −1 1 1 1 −1 −1 −1 1 1 1 −1 1 1 1 −1 1 |
| | −1 −1 1 1 1 1 1 −1 1 1 1 1 1 −1 1 1 −1 1 1 −1 1 1 −1 1 1 −1 −1 −1 1 −1 1 1 −1 −1 |
| | −1 1 1 1 −1 −1 1 −1 1 −1 −1 1 1 1 −1 1 1 −1 1 −1 1 1 1 −1 1 1 −1 −1 −1 −1 −1 1 1 |
| | 1 1 1 1 −1 1 1 −1 1 −1 −1 −1 1 −1 −1 −1 1 −1 1 −1 1 −1 −1 −1 1 1 1 1 −1 1 −1 −1 |
| | −1 −1 −1 −1 −1 1 1 −1 1 1 1 1 1 1 1 −1 1 1 −1 −1 1 −1 1 1 −1 1 1 −1 −1 1 −1 1 −1 |
| | 1 1 −1 −1 −1 −1 1 −1 −1 1 1 −1 −1 1 1 −1 1 1 −1 −1 1 −1 −1 −1 −1 1 −1 1 1 1 1 1 |
| | 1 −1 −1 1 −1 −1 −1 −1 1 −1 1 −1 −1 −1 1 −1 −1 −1 −1 1 1 1 1 −1 1 1 −1 1 1 1 −1 |
| | 1 1 1 1 1 1 1 1 −1 1 1 −1 1 1 −1 −1 −1 1 1 −1 −1 −1 1 −1 1 −1 −1 1 1 −1 1 −1 −1 |
| | −1 −1 −1 1 −1 −1 −1 1 1 −1 1 1 −1 1 1 −1 1 −1 −1 −1 1 −1 1 1 −1 −1 −1 −1 1 1 1 |
| | 1 −1 −1 −1 −1 −1 1 1 1 −1 −1 1 1 1 1 1 −1 1 −1 −1 1 −1 −1 1 −1 1 −1 1 −1 1 1 −1 |
| | −1 −1 1 1 1 −1 1 −1 1 1 1 −1 1 −1 −1 1 −1 −1 1 −1 −1 1 −1 −1 −1 1 −1 1 1 −1 −1 |
| | −1 1 −1 −1 1 −1 −1 −1 1 1 1 −1 −1 −1 1 −1 1 −1 −1 1 1 1 −1 1 −1 1 −1 −1 −1 1 1 |
| | 1 −1 −1 1 1 1 1 −1 1 −1 −1 1 1 −1 1 −1 1 −1 1 −1 1 1 1 1 1 −1 1 −1 −1 1 1 −1 1 1 |
| | −1 1 1 1 1 1 −1 −1 −1 1 −1 1 1 1 1 1 −1 1 −1 −1 −1 −1 1 1 −1 −1 1 −1 −1 −1 −1 1 |
| | 1 1 1 −1 −1 −1 1 1 −1 1 −1 −1 −1 −1 −1 −1 −1 −1 1 −1 −1 −1 −1 1 −1 1 1 −1 1 1 |
| | −1 1 1 1 1 −1 −1 −1 1 −1 1 1 −1 1 1 1 −1 1 −1 1 −1 1 1 −1 −1 1 1 −1 1 −1 −1 1 −1 |
| | 1 −1 1 −1 1 1 1 1 1 1 −1 1 −1 −1 1 −1 −1 −1 1 −1 −1 −1 −1 1 −1 1 1 1 −1 −1 −1 |
| | −1 1 1 −1 1 1 1 −1 1 −1 1 −1 −1 −1 1 −1 −1 1 −1 −1 1 1 −1 1 −1 1 1 −1 −1 −1 1 1 |
| | −1 −1 1 1 −1 −1 1 1 1 −1 −1 1 −1 −1 −1 −1 1 1 1 −1 1 1 −1 −1 1 −1 −1 1 1 1 1 1 1 |
| | −1 −1 −1 1 −1 −1 1 −1 1 1 1 −1 1 −1 1 1 −1 −1 1 −1 −1 1 −1 −1 1 −1 1 −1 1 1 −1 |
| | −1 −1 1 −1 1 −1 −1 1 −1 1 −1 −1 1 −1 −1 1 −1 1 1 1 −1 −1 −1 1 −1 1 1 1 1 −1 1 |
| | −1 −1 1 −1 −1 −1 −1 1 1 −1 1 1 −1 −1 −1 −1 1 1 1 1 1 1 1 −1 1 1 1 −1 1 1 −1 −1 |
| | −1 −1 1 −1 −1 1 −1 1 1 1 −1 −1 1 −1 1 1 −1 1 1 1 −1 1 1 −1 1 1 −1 −1 −1 −1 −1 1 |
| | −1 1 1 −1 −1 1 1 −1 −1 1 −1 −1 −1 1 1 −1 1 1 1 1 1 1 −1 1 −1 1 1 −1 1 1 −1 −1 1 |
| | −1 −1 1 −1 1 1 −1 −1 1 −1 1 1 −1 −1 1 −1 1 −1 1 1 1 1 1 −1 −1 −1 −1 −1 −1 1 1 |
| | −1 −1 1 1 1 1 1 1 −1 1 1 1 1 −1 1 1 −1 −1 1 −1 1 −1 1 −1 1 1 −1 1 1 −1 1 −1 −1 1 |
| | 1 −1 −1 −1 1 −1 1 −1 1 1 1 1 −1 1 −1 1 −1 −1 1 −1 −1 −1 −1 1 1 1 −1 −1 −1 1 −1 |
| | −1 −1 −1 −1 −1 −1 −1 −1 −1 1 −1 −1 −1 1 −1 1 1 −1 −1 1 −1 1 −1 −1 −1 −1 1 −1 |
| | −1 −1 1 1 1 1 −1 −1 1 −1 1 −1 −1 1 1 −1 1 −1 1 1 1 −1 −1 −1 −1 1 −1 −1 1 −1 −1 |
| | 1 1 1 1 −1 −1 −1 1 −1 1 1 1 −1 −1 1 1 1 −1 −1 1 −1 −1 1 1 −1 1 −1 −1 1 −1 1 1 −1 |
| | 1 1 −1 1 1 −1 −1 1 −1 1 1 −1 −1 −1 1 −1 −1 −1 1 1 −1 −1 1 1 1 1 1 −1 1 −1 1 −1 1 |
| | −1 −1 −1 1 1 −1 1 −1 −1 1 1 −1 1 −1 −1 −1 1 1 −1 −1 1 −1 1 −1 1 −1 −1 1 −1 −1 |
| | −1 1 1 1 −1 1 1 −1 −1 −1 −1 −1 −1 −1 −1 1 −1 1 −1 −1 −1 1 −1 1 1 1 1 −1 1 1 1 |
| | −1 −1 1 −1 −1 −1 −1 1 −1 −1 1 1 −1 −1 −1 −1 1 1 −1 −1 −1 −1 1 1 1 1 −1 1 1 1 −1 |
| | −1 1 1 1 1 −1 −1 −1 −1 −1 −1 1 1 1 1 −1 1 −1 1 1 −1 1 −1 −1 −1 −1 1 1 1 1 1 1 −1 |
| | −1 1 −1 −1 1 1 −1 −1 −1 −1 −1 1 1 1 1 −1 1 1 −1 1 1 1 1 −1 −1 1 −1 1 1 −1 |
| | −1 1 −1 −1 1 −1 1 −1 1 1 1 1 1 1 1 1 −1 1 −1 1 −1 1 1 −1 −1 −1 1 1 1 −1 1 1 −1 |
| | 1 −1 1 −1 −1 1 1 −1 −1 −1 1 1 1 −1 −1 −1 −1 1 1 1 −1 1 −1 −1 1 1 −1 1 −1 −1 1 |
| | −1 −1 −1 1 1 −1 −1 1 −1 1 1 −1 1 −1 −1 −1 −1 1 −1 −1 −1 1 −1 −1 −1 −1 1 1 −1 |
| | −1 1 1 −1 −1 1 −1 −1 1 −1 −1 −1 −1 1 1 −1 −1 −1 1 −1 1 −1 1 −1 −1 −1 −1 −1 −1 |
| | 1 1 1 −1 1 1 1 1 1 1 −1 1 −1 −1 −1 1 1 −1 −1 −1 −1 1 1 −1 1 −1 −1 −1 −1 −1 1 1 1 |
| | 1 1 −1 −1 1 −1 1 −1 −1 1 −1 1 −1 −1 −1 1 1 1 1 1 1 −1 1 1 1 −1 1 −1 1 1 −1 1 1 −1 |
| | 1 −1 1 −1 −1 −1 1 −1 1 1 −1 1 −1 −1 −1 −1 −1 1 1 −1 −1 −1 −1 1 1 −1 −1 1 1 −1 1 |
| | −1 1 −1 −1 −1 −1 1 1 −1 −1 1 1 1 1 −1 −1 1 1 −1 1 1 1 −1 −1 1 1 −1 1 1 −1 −1 1 1 |
| | 1 1 −1 −1 −1 1 −1 −1 −1 −1 −1 1 1 1 −1 1 1 −1 1 1 −1 1 −1 −1 1 −1 1 1 −1 −1 −1 |
| | 1 1 −1 −1 −1 −1 1 −1 −1 1 1 1 1 −1 1 1 1 1 1 1 −1 1 1 1 1 1 −1 −1 −1 1 1 −1 −1 1 |
| | −1 1 −1 −1 1 1 1 1 −1 −1 −1 −1 −1 1 −1 −1 1 −1 −1 1 1 −1 −1 1 −1 1 1 −1 −1 −1 |
| | −1 1 1 −1 −1 1 −1 1 −1 −1 −1 −1 −1 1 1 −1 −1 1 1 −1 1 1 −1 1 −1 1 −1 1 −1 1 1 |
| | −1 −1 −1 −1 −1 −1 −1 −1 −1 1 −1 −1 1 −1 1 1 −1 −1 −1 −1 1 −1 1 1 1 1 1 −1 1 1 1 |
| | 1 −1 −1 1 −1 1 −1 1 1 1 1 −1 1 1 −1 1 −1 −1 −1 −1 1 1 −1 −1 −1 1 1 −1 1 1 1 −1 |
| | −1 1 1 1 −1 −1 −1 1 1 1 −1 −1 1 1 1 −1 1 −1 −1 1 1 1 1 −1 1 −1 1 −1 1 1 1 −1 −1 1 |
| | −1 −1 1 1 1 1 −1 1 −1 1 1 −1 −1 1 1 −1 1 1 1 −1 −1 −1 −1 1 1 −1 −1 −1 −1 −1 −1 |
| | −1 1 1 1 1 −1 1 1 −1 −1 −1 −1 −1 −1 1 1 −1 −1 −1 −1 −1 1 −1 1 −1 −1 −1 −1 −1 1 |
| | −1 −1 −1 −1 −1 1 1 −1 −1 1 −1 1 −1 1 1 1 −1 −1 1 −1 1 −1 −1 1 −1 −1 1 1 −1 −1 1 |
| | 1 −1 −1 −1 1 −1 −1 −1 −1 1 1 −1 1 −1 −1 −1 1 1 −1 1 −1 1 1 1 1 −1 1 −1 1 1 1 −1 |
| | −1 1 −1 −1 −1 −1 −1 1 1 1 −1 −1 −1 1 1 −1 −1 1 1 1 −1 1 −1 −1 1 −1 −1 −1 −1 −1 |
| | −1 1 1 −1 −1 −1 1 1 −1 −1 −1 −1 −1 1 1 1 −1 1 1 1 −1 −1 −1 −1 −1 −1 −1 1 −1 −1 |
| | 1 1 1 1 1 1 1 −1 −1 −1 1 1 1 1 1 1 1 −1 1 −1 −1 1 1 −1 −1 −1 1 1 −1 1 1 −1 1 1 1 |
| | −1 1 −1 1 1 −1 −1 −1 1 1 1 1 −1 1 1 −1 1 −1 −1 1 1 −1 1 1 −1 −1 −1 −1 1 −1 −1 |
| | −1 1 −1 1 −1 −1 −1 −1 1 −1 −1 1 −1 −1 1 −1 −1 −1 −1 1 −1 1 1 −1 −1 −1 1 1 −1 1 |
| | 1 1 1 1 −1 1 −1 −1 −1 1 −1 −1 −1 1 1 −1 1 1 1 −1 −1 −1 −1 −1 −1 1 −1 1 −1 −1 1 |
| | 1 −1 −1 −1 −1 1 1 1 1 1 −1 −1 1 1 −1 1 −1 −1 −1 1 1 1 1 −1 −1 −1 −1 1 1 1 −1 1 1 |
| | 1 −1 1 1 1 −1 1 −1 1 1 1 −1 −1 −1 −1 −1 1 1 1 1 −1 1 −1 −1 −1 1 1 1 −1 −1 1 −1 |
| | −1 −1 −1 −1 −1 −1 −1 −1 1 −1 1 −1 1 1 −1 −1 −1 1 1 −1 1 −1 −1 −1 1 1 1 −1 1 1 |
| | −1 1 1 1 −1 1 −1 −1 −1 1 −1 1 1 1 −1 −1 1 −1 −1 1 −1 −1 −1 −1 −1 −1 1 −1 1 1 −1 |
| | −1 1 −1 1 1 1 1 −1 −1 −1 −1 1 −1 −1 −1 −1 1 1 1 −1 −1 1 −1 1 −1 1 −1 −1 1 1 1 1 |
| | 1 −1 1 −1 −1 −1 1 1 1 1 1 −1 −1 1 −1 −1 1 1 1 1 1 −1 1 1 −1 −1 −1 −1 −1 1 −1 −1 |
| | −1 1 −1 −1 1 −1 1 −1 1 1 1 −1 −1 −1 1 −1 −1 1 1 −1 1 −1 −1 1 1 −1 −1 −1 −1 1 −1 |
| | −1 −1 1 1 −1 1 −1 1 −1 1 1 1 −1 1 1 −1 1 −1 −1 1 −1 −1 1 −1 1 1 −1 1 1 −1 −1 −1 |
| | 1 −1 −1 −1 1 −1 1 1 1 −1 1 1 −1 1 −1 1 −1 1 −1 −1 −1 1 −1 1 −1 −1 1 1 1 1 −1 1 1 |
| | 1 −1 −1 −1 −1 −1 1 1 −1 −1 1 1 1 −1 −1 −1 −1 −1 1 1 −1 1 −1 −1 1 1 −1 −1 1 1 −1 |
| | −1 1 −1 1 −1 1 −1 1 −1 1 −1 1 1 1 −1 1 −1 −1 1 1 1 −1 −1 1 1 −1 1 1 −1 1 −1 −1 1 |
| | −1 −1 −1 1 −1 1 1 1 1 1 1 1 −1 1 1 1 1 −1 −1 −1 1 −1 −1 −1 1 1 −1 1 −1 −1 1 −1 1 |
| | −1 −1 1 −1 1 −1 1 1 −1 1 −1 1 1 −1 1 −1 −1 −1 1 −1 −1 1 −1 1 1 1 1 −1 1 1 −1 −1 |
| | −1 −1 1 1 −1 1 1 −1 −1 1 1 −1 1 −1 1 1 −1 −1 1 −1 −1 −1 1 1 1 1 1 −1 −1 −1 1 1 1 |
| | −1 1 1 −1 1 −1 −1 1 1 1 −1 −1 −1 1 −1 −1 −1 1 1 1 −1 1 −1 −1 −1 1 1 1 −1 1 −1 1 |
| | −1 1 −1 −1 1 1 1 1 −1 1 −1 −1 1 −1 1 −1 −1 −1 −1 1 1 −1 −1 −1 −1 −1 1 1 −1 1 −1 |
| | 1 −1 −1 −1 1 1 1 1 1 −1 1 −1 1 −1 −1 1 1 −1 −1 1 −1 −1 1 1 −1 −1 1 −1 −1 −1 1 |
| | −1 1 −1 1 −1 1 1 −1 1 −1 1 −1 −1 1 1 1 1 1 1 −1 1 −1 1 1 1 −1 −1 −1 1 1 −1 1 −1 1 |
| | −1 −1 1 1 1 −1 −1 −1 −1 −1 −1 1 −1 −1 1 1 1 −1 −1 −1 1 1 −1 −1 −1 −1 −1 −1 −1 |
| | −1 −1 −1 1 1 1 1 1 1 1 1 1 1 −1 1 −1 1 1 −1 −1 −1 1 −1 −1 −1 −1 −1 1 −1 −1 1 1 |
| | −1 −1 1 −1 1 −1 1 1 −1 1 1 1 1 1 −1 1 −1 1 1 −1 −1 1 −1 1 −1 1 −1 −1 −1 1 1 −1 |
| | −1 1 1 1 −1 −1 1 1 1 1 −1 −1 1 1 1 −1 −1 1 1 −1 1 −1 1 −1 −1 1 1 −1 1 1 −1 1 −1 |
| | −1 −1 1 1 −1 −1 −1 1 −1 −1 −1 −1 −1 −1 1 1 1 −1 −1 −1 −1 1 −1 1 −1 −1 1 1 1 −1 |
| | −1 1 −1 −1 1 −1 1 −1 −1 1 1 −1 −1 −1 1 −1 −1 1 −1 1 −1 1 −1 −1 1 −1 1 1 −1 1 −1 |
| | −1 1 −1 1 1 1 1 1 1 −1 −1 −1 1 1 −1 1 1 −1 −1 1 1 1 −1 1 1 −1 −1 −1 −1 1 1 1 −1 |
| | −1 −1 1 1 1 1 −1 1 −1 −1 1 1 1 −1 1 1 1 1 −1 −1 −1 −1 −1 −1 1 −1 −1 −1 −1 −1 −1 |
| | 1 −1 1 −1 1 1 1 1 1 1 −1 −1 1 1 1 1 −1 −1 −1 1 1 1 1 −1 1 1 1 −1 1 −1 1 −1 −1 |
| | −1 1 1 1 1 −1 −1 −1 1 −1 −1 1 1 1 1 −1 1 −1 −1 −1 1 −1 −1 1 −1 −1 −1 −1 1 1 1 1 |
| | 1 1 1 1 −1 −1 1 1 1 1 1 1 1 1 −1 1 1 1 −1 −1 −1 1 −1 1 −1 1 1 1 −1 1 −1 −1 −1 −1 |
| | −1 −1 1 1 1 1 −1 −1 1 −1 1 1 1 −1 1 1 1 −1 −1 −1 −1 1 1 1 1 1 −1 1 −1 −1 −1 −1 |
| | −1 −1 1 −1 −1 −1 −1 1 1 −1 −1 −1 −1 1 −1 −1 −1 −1 −1 1 1 1 1 −1 −1 −1 −1 1 −1 |
| | −1 1 1 −1 1 −1 −1 −1 −1 1 −1 1 −1 1 1 1 1 −1 −1 1 −1 −1 1 1 −1 1 1 1 −1 −1 −1 1 |
| | −1 −1 −1 1 −1 −1 1 1 1 −1 −1 −1 −1 −1 1 −1 1 −1 −1 1 1 1 1 1 −1 −1 1 1 −1 −1 1 |
| | 1 −1 −1 1 1 −1 1 1 1 1 −1 −1 1 −1 −1 −1 1 −1 −1 −1 −1 −1 1 −1 1 −1 −1 −1 1 1 −1 |
| | −1 1 −1 −1 1 −1 −1 1 1 −1 1 1 −1 −1 −1 1 −1 1 −1 1 1 −1 −1 1 1 1 1 −1 1 −1 1 1 1 |
| | 1 −1 1 1 1 1 −1 1 1 1 1 −1 −1 −1 −1 1 1 −1 −1 1 −1 −1 1 1 −1 1 −1 1 −1 1 1 −1 −1 |
| | 1 −1 1 −1 −1 1 1 −1 −1 1 −1 1 −1 −1 −1 1 1 −1 1 1 −1 1 −1 1 −1 −1 1 −1 1 1 −1 |
| | −1 1 1 1 1 1 1 −1 −1 −1 −1 1 1 1 1 1 1 −1 1 −1 1 −1 −1 1 −1 1 1 1 1 −1 1 −1 1 1 |
| | −1 1 1 1 1 −1 −1 1 1 −1 −1 −1 1 1 −1 1 −1 1 −1 1 −1 −1 1 1 −1 −1 1 1 1 −1 1 1 −1 |
| | 1 1 1 1 −1 1 −1 1 1 −1 −1 −1 −1 1 1 −1 1 −1 1 1 1 −1 −1 1 1 −1 −1 1 1 −1 1 −1 −1 |
| | −1 −1 1 1 −1 1 1 −1 1 1 1 1 −1 1 1 −1 −1 −1 1 −1 −1 −1 −1 1 −1 −1 1 −1 1 |
| | −1 1 −1 1 −1 −1 −1 1 −1 −1 1 1 1 −1 1 1 1 −1 −1 −1 1 1 1 |
| 7 | −1 −1 −1 −1 −1 −1 −1 −1 −1 −1 −1 −1 −1 1 1 1 1 1 −1 −1 −1 1 1 1 1 1 −1 −1 1 −1 |
| | −1 1 1 −1 1 1 −1 1 1 1 1 1 −1 1 −1 1 1 −1 1 1 −1 1 −1 1 −1 −1 1 −1 −1 −1 1 1 −1 |
| | −1 1 −1 −1 1 −1 −1 −1 −1 1 −1 1 −1 1 −1 1 −1 1 −1 1 −1 1 1 1 1 1 1 −1 1 −1 −1 |
| | −1 −1 −1 −1 1 −1 −1 1 −1 −1 −1 1 1 1 −1 −1 −1 −1 −1 −1 1 1 −1 −1 −1 1 1 1 −1 |
| | −1 1 1 −1 1 1 −1 1 −1 −1 −1 1 −1 −1 1 −1 −1 1 −1 1 −1 −1 1 1 −1 −1 1 1 −1 −1 1 |
| | 1 −1 −1 −1 −1 −1 −1 −1 1 1 −1 1 −1 1 −1 1 1 −1 1 1 −1 1 −1 −1 −1 −1 1 −1 1 −1 1 |
| | −1 −1 −1 1 −1 1 1 1 1 −1 1 1 1 −1 −1 −1 1 1 −1 1 −1 −1 1 −1 −1 1 −1 −1 1 1 −1 1 |
| | 1 1 −1 1 1 1 −1 1 1 1 −1 1 −1 1 −1 1 −1 −1 −1 1 1 −1 −1 1 1 1 −1 −1 −1 1 1 −1 1 |
| | −1 1 1 −1 −1 1 1 −1 1 −1 −1 1 1 1 1 1 −1 −1 −1 −1 1 −1 1 1 1 −1 −1 1 −1 −1 1 −1 |
| | −1 1 −1 −1 −1 1 1 1 1 −1 −1 −1 −1 1 1 1 1 −1 −1 1 1 −1 −1 1 −1 1 1 1 −1 1 1 1 1 |
| | −1 1 −1 −1 −1 1 1 −1 −1 −1 1 −1 −1 −1 1 1 −1 1 1 1 1 1 −1 1 −1 1 1 −1 −1 −1 |
| | −1 1 −1 −1 1 −1 −1 1 −1 −1 1 −1 1 1 1 1 1 −1 1 −1 1 1 1 1 1 −1 1 1 1 −1 1 1 −1 −1 |
| | −1 −1 1 1 1 1 1 −1 −1 1 −1 1 1 1 −1 1 −1 −1 1 −1 1 1 1 −1 −1 −1 −1 −1 −1 −1 1 1 |
| | −1 −1 −1 1 −1 1 −1 −1 1 −1 −1 1 −1 −1 1 −1 −1 1 1 1 1 1 1 −1 −1 1 1 1 1 1 1 −1 |
| | −1 −1 −1 1 1 1 −1 1 −1 1 1 1 1 1 1 −1 1 1 −1 −1 −1 −1 1 1 −1 1 1 −1 −1 −1 −1 1 |
| | −1 1 −1 1 −1 1 1 1 −1 1 −1 −1 1 1 −1 1 1 −1 1 1 −1 1 1 −1 1 1 1 1 1 1 1 −1 1 1 1 1 |
| | 1 1 1 −1 1 −1 1 1 1 1 −1 −1 1 1 1 1 1 1 1 −1 −1 −1 1 −1 1 −1 −1 −1 1 1 1 −1 1 −1 |
| | 1 1 −1 −1 1 1 −1 −1 −1 −1 1 1 −1 1 1 1 −1 −1 −1 1 1 1 −1 −1 −1 1 1 1 1 1 1 1 1 −1 |
| | −1 −1 −1 −1 −1 −1 −1 1 1 −1 −1 −1 −1 −1 1 −1 −1 −1 −1 −1 −1 −1 −1 1 −1 1 1 −1 |
| | −1 1 −1 1 1 1 1 −1 −1 1 1 1 −1 1 1 1 −1 1 −1 1 1 1 −1 −1 −1 −1 1 −1 1 1 1 1 −1 1 |
| | −1 −1 −1 −1 −1 −1 −1 −1 −1 1 −1 1 −1 1 −1 1 −1 −1 −1 1 −1 1 −1 1 1 −1 1 −1 1 |
| | −1 1 −1 1 1 −1 −1 −1 1 −1 −1 1 1 1 1 1 −1 1 1 1 1 −1 −1 −1 −1 1 1 −1 −1 −1 −1 1 |
| | −1 1 −1 −1 1 1 1 1 1 −1 −1 1 −1 1 −1 1 −1 1 −1 1 1 −1 −1 1 1 −1 −1 1 −1 1 1 −1 |
| | −1 1 1 1 −1 −1 1 1 −1 −1 1 1 1 −1 1 −1 −1 1 −1 −1 −1 −1 −1 −1 1 1 1 1 1 −1 1 −1 |
| | 1 1 1 −1 1 −1 1 1 −1 −1 1 −1 −1 −1 −1 −1 −1 1 −1 −1 1 1 −1 −1 1 1 −1 −1 −1 1 −1 |
| | −1 −1 1 −1 −1 1 1 1 −1 1 1 1 1 −1 1 1 1 −1 1 1 1 1 −1 −1 1 −1 −1 1 −1 1 −1 1 −1 |
| | −1 −1 −1 −1 −1 1 1 −1 −1 −1 −1 1 1 −1 −1 −1 1 −1 −1 1 −1 1 −1 1 −1 −1 1 −1 −1 |
| | −1 1 −1 −1 −1 1 −1 1 1 −1 1 −1 −1 1 −1 −1 −1 −1 1 1 1 1 1 −1 −1 −1 −1 1 1 1 1 1 |
| | −1 1 1 −1 1 −1 1 1 −1 1 −1 1 −1 1 1 1 −1 1 −1 1 1 1 −1 1 −1 −1 1 −1 −1 1 1 |
| | −1 −1 1 −1 −1 1 −1 1 1 −1 1 −1 −1 1 1 1 −1 −1 1 −1 −1 1 −1 1 −1 −1 −1 −1 −1 −1 |
| | 1 −1 1 −1 −1 −1 −1 −1 −1 1 1 1 −1 −1 −1 1 −1 −1 −1 1 1 −1 −1 1 1 1 1 −1 −1 1 1 |
| | 1 1 −1 −1 1 −1 −1 1 −1 −1 −1 1 −1 −1 1 −1 −1 1 1 1 −1 −1 1 −1 −1 −1 −1 1 −1 −1 |
| | 1 −1 −1 1 1 −1 1 −1 1 −1 1 1 −1 −1 1 −1 1 −1 1 −1 −1 −1 −1 1 −1 1 1 −1 1 −1 −1 |
| | −1 1 −1 −1 −1 −1 −1 1 −1 −1 −1 −1 −1 1 −1 −1 1 −1 −1 1 −1 1 1 −1 1 1 −1 1 1 1 1 |
| | −1 1 1 −1 1 −1 1 1 −1 1 1 −1 1 1 1 −1 −1 1 1 −1 −1 −1 1 −1 −1 1 1 −1 −1 1 −1 1 |
| | −1 −1 1 1 1 −1 −1 1 −1 1 1 −1 1 −1 1 −1 −1 1 −1 1 −1 1 1 −1 1 1 −1 1 1 −1 −1 −1 |
| | 1 1 1 −1 −1 −1 −1 −1 1 1 1 −1 −1 1 1 1 −1 −1 −1 1 1 1 1 −1 1 1 1 −1 1 −1 −1 1 −1 |
| | −1 −1 1 −1 −1 1 1 −1 1 1 1 1 −1 1 1 −1 −1 −1 1 1 −1 −1 1 −1 −1 1 1 −1 −1 −1 1 1 |
| | 1 −1 −1 −1 1 −1 1 1 1 1 −1 1 −1 1 −1 −1 −1 −1 1 −1 −1 −1 −1 1 −1 1 1 1 1 1 −1 |
| | −1 −1 −1 1 1 −1 1 1 −1 1 −1 −1 1 −1 −1 −1 1 1 1 1 1 −1 −1 −1 1 −1 1 1 1 −1 1 1 |
| | −1 1 1 1 −1 1 −1 −1 −1 −1 1 −1 1 1 −1 −1 −1 −1 −1 1 1 −1 −1 1 −1 1 −1 −1 1 −1 1 |
| | −1 −1 1 1 1 1 1 1 −1 1 −1 1 1 1 −1 −1 −1 1 1 −1 1 1 −1 1 −1 −1 −1 −1 −1 −1 1 −1 |
| | 1 1 −1 −1 −1 −1 1 1 1 −1 −1 −1 −1 1 1 −1 1 −1 1 1 −1 −1 −1 1 −1 1 −1 1 1 1 −1 1 |
| | 1 −1 −1 1 −1 −1 1 1 −1 1 1 1 1 1 1 1 −1 −1 1 1 1 1 −1 1 −1 −1 −1 1 1 1 −1 −1 1 −1 |
| | 1 −1 1 −1 1 1 1 −1 1 −1 1 1 1 1 −1 1 −1 1 1 1 −1 −1 1 1 1 −1 1 −1 −1 1 1 −1 −1 |
| | −1 −1 1 1 1 −1 1 1 −1 1 1 1 −1 −1 −1 −1 −1 −1 −1 −1 1 −1 −1 −1 −1 −1 1 1 −1 1 |
| | −1 −1 −1 −1 1 −1 −1 1 1 −1 −1 1 −1 −1 −1 −1 1 1 −1 −1 −1 −1 −1 −1 1 1 −1 −1 1 |
| | −1 1 −1 −1 −1 −1 1 1 −1 1 1 1 −1 1 −1 1 1 1 1 −1 −1 −1 1 1 1 1 −1 1 −1 1 −1 1 −1 |
| | 1 1 −1 1 −1 1 −1 −1 −1 1 1 −1 1 −1 1 1 −1 1 1 1 −1 1 1 −1 1 −1 1 1 1 −1 1 −1 1 −1 |
| | −1 −1 1 −1 1 −1 −1 1 −1 1 −1 −1 −1 1 1 1 1 −1 −1 1 1 1 1 1 −1 1 −1 −1 −1 −1 −1 |
| | 1 1 −1 −1 1 1 −1 −1 −1 1 1 −1 −1 1 −1 1 1 1 −1 −1 1 1 1 −1 −1 −1 −1 1 1 1 −1 −1 |
| | 1 1 1 1 −1 −1 1 1 −1 1 −1 −1 1 1 −1 1 1 −1 −1 1 −1 1 1 1 1 1 −1 1 1 1 1 1 1 −1 −1 |
| | 1 −1 1 −1 1 1 1 −1 1 1 1 −1 1 −1 −1 −1 1 −1 −1 1 1 1 1 −1 1 1 1 1 −1 1 −1 1 1 1 1 |
| | −1 1 1 1 1 1 −1 1 1 1 −1 −1 1 −1 −1 −1 1 1 1 −1 1 1 −1 −1 −1 −1 −1 −1 1 1 1 1 1 1 |
| | 1 −1 1 1 −1 −1 1 1 1 1 −1 −1 −1 −1 1 1 −1 1 −1 −1 1 −1 −1 −1 −1 −1 1 1 1 1 1 −1 |
| | −1 1 1 1 1 1 −1 −1 −1 −1 −1 −1 1 1 1 1 −1 1 1 −1 1 −1 −1 −1 −1 1 1 1 −1 1 −1 1 |
| | −1 1 1 1 1 1 1 1 1 −1 −1 −1 1 −1 −1 −1 −1 −1 1 −1 1 −1 −1 −1 1 1 −1 1 1 −1 1 −1 |
| | 1 −1 −1 −1 −1 −1 −1 1 −1 −1 −1 −1 −1 −1 1 −1 1 −1 1 −1 −1 −1 −1 −1 1 1 1 −1 |
| | −1 1 −1 1 −1 −1 −1 −1 1 1 −1 −1 1 1 1 1 1 1 1 1 1 −1 1 −1 −1 1 −1 1 −1 1 1 −1 −1 |
| | 1 −1 1 1 1 −1 −1 −1 1 1 −1 −1 1 −1 1 −1 1 −1 −1 1 −1 1 −1 1 −1 −1 1 1 −1 −1 1 |
| | −1 1 −1 1 1 1 1 −1 1 1 −1 −1 1 −1 1 −1 −1 −1 1 −1 −1 −1 −1 −1 −1 −1 −1 −1 −1 1 |
| | 1 −1 1 1 −1 −1 1 1 1 −1 1 1 −1 −1 −1 −1 1 −1 1 1 1 −1 1 1 −1 −1 1 1 −1 1 1 −1 −1 |
| | 1 1 −1 1 1 1 −1 1 1 −1 −1 1 1 1 1 1 −1 −1 −1 1 −1 −1 1 1 −1 1 −1 −1 1 −1 1 −1 1 |
| | −1 1 −1 1 −1 −1 −1 1 1 1 −1 1 1 1 1 −1 −1 −1 1 −1 1 −1 −1 1 1 1 1 −1 −1 −1 1 −1 |
| | −1 −1 1 1 1 −1 1 1 1 −1 −1 −1 −1 1 1 1 −1 1 1 1 1 1 1 −1 1 −1 −1 1 −1 −1 −1 1 1 |
| | −1 1 1 −1 −1 1 1 −1 −1 1 1 −1 1 −1 −1 −1 −1 1 1 1 1 1 −1 1 −1 −1 1 1 −1 1 1 1 1 1 |
| | −1 1 −1 −1 1 −1 1 1 1 1 −1 −1 −1 −1 1 −1 1 −1 −1 −1 −1 1 1 1 1 1 1 1 −1 −1 1 −1 |
| | −1 1 −1 1 1 1 −1 −1 −1 1 −1 −1 −1 1 −1 −1 −1 1 1 −1 1 −1 1 1 1 1 1 1 −1 −1 1 −1 |
| | −1 −1 1 1 1 1 1 1 −1 −1 1 −1 −1 1 1 1 1 1 −1 1 −1 1 1 −1 −1 1 −1 1 −1 −1 −1 −1 |
| | −1 −1 −1 −1 1 −1 −1 1 −1 −1 1 1 1 1 −1 1 −1 −1 1 −1 1 1 −1 1 −1 −1 −1 1 1 −1 −1 |
| | −1 −1 −1 −1 −1 1 −1 −1 1 −1 1 1 1 1 1 1 1 −1 1 1 −1 1 1 1 1 1 1 −1 −1 1 1 1 −1 1 |
| | 1 −1 −1 1 −1 1 −1 1 −1 1 −1 −1 1 −1 −1 1 −1 −1 −1 −1 −1 1 1 −1 1 1 −1 −1 −1 1 1 |
| | −1 1 −1 −1 −1 1 −1 1 −1 1 −1 1 1 −1 1 1 −1 −1 −1 −1 −1 −1 −1 −1 1 1 1 −1 −1 −1 |
| | −1 −1 −1 −1 1 −1 −1 −1 −1 1 1 1 −1 1 1 −1 −1 1 1 −1 −1 1 −1 −1 1 −1 −1 1 −1 1 |
| | −1 1 1 1 −1 −1 −1 1 −1 1 1 1 −1 −1 1 −1 1 1 −1 −1 1 1 −1 −1 −1 1 1 1 −1 1 −1 1 |
| | −1 1 −1 1 1 1 1 −1 1 −1 1 −1 1 −1 −1 1 −1 1 −1 −1 −1 −1 1 1 1 −1 1 1 1 −1 1 1 −1 |
| | 1 1 −1 1 1 −1 −1 1 1 1 1 −1 1 −1 −1 1 1 1 1 −1 1 1 −1 −1 −1 1 −1 −1 −1 1 −1 1 1 1 |
| | 1 −1 −1 1 1 −1 −1 1 1 1 1 1 −1 −1 1 1 −1 −1 1 −1 −1 1 1 −1 1 −1 1 1 1 1 −1 −1 −1 |
| | −1 1 1 1 −1 −1 −1 1 1 1 −1 1 1 1 1 1 −1 −1 1 −1 −1 −1 −1 −1 1 1 1 −1 1 −1 −1 1 |
| | −1 1 1 −1 −1 −1 −1 −1 1 −1 −1 −1 1 −1 −1 −1 −1 −1 −1 1 −1 −1 −1 1 −1 −1 1 −1 |
| | −1 −1 1 1 −1 −1 −1 −1 −1 1 −1 1 −1 −1 −1 −1 1 −1 1 1 1 1 −1 −1 −1 −1 −1 −1 1 |
| | −1 −1 1 −1 1 −1 1 1 1 1 −1 −1 1 −1 −1 1 1 1 −1 1 −1 1 −1 −1 1 −1 1 1 −1 1 −1 1 |
| | −1 1 1 −1 1 −1 −1 1 −1 −1 1 −1 1 1 1 −1 1 −1 1 −1 −1 1 1 −1 1 −1 1 1 −1 −1 −1 |
| | −1 −1 1 −1 1 −1 1 −1 −1 1 −1 −1 1 1 −1 −1 −1 −1 −1 1 −1 −1 1 −1 −1 −1 −1 1 1 |
| | −1 −1 1 −1 −1 1 1 1 −1 −1 1 1 −1 −1 −1 1 1 −1 1 1 −1 1 1 −1 −1 −1 −1 1 1 −1 −1 |
| | 1 −1 −1 −1 1 1 −1 −1 −1 1 −1 1 −1 1 1 −1 −1 1 1 −1 1 1 −1 1 1 1 −1 1 −1 1 −1 −1 |
| | 1 −1 −1 1 −1 1 −1 −1 −1 1 −1 −1 1 −1 −1 −1 −1 1 −1 −1 −1 1 −1 1 1 1 −1 −1 −1 1 |
| | 1 1 −1 1 −1 1 1 1 −1 1 1 −1 1 −1 −1 −1 1 −1 1 1 −1 −1 1 1 1 −1 1 1 1 −1 −1 −1 1 1 |
| | 1 1 −1 −1 1 1 −1 1 1 −1 1 1 −1 −1 1 −1 1 1 −1 1 1 −1 1 −1 1 1 −1 1 −1 −1 1 1 1 1 |
| | −1 1 −1 −1 −1 −1 1 1 −1 −1 −1 −1 1 1 1 −1 −1 1 −1 1 1 −1 −1 −1 1 −1 −1 −1 −1 1 |
| | 1 1 1 −1 1 −1 −1 −1 −1 −1 1 −1 −1 −1 1 1 1 −1 −1 −1 1 −1 −1 1 1 1 −1 −1 −1 1 1 1 |
| | −1 −1 −1 1 1 −1 1 1 1 1 1 −1 −1 1 −1 1 −1 −1 −1 1 −1 1 −1 −1 −1 −1 1 −1 −1 1 1 |
| | 1 −1 1 −1 −1 1 −1 1 −1 −1 −1 −1 −1 1 1 −1 1 −1 1 −1 −1 1 −1 1 1 1 1 −1 1 −1 −1 |
| | 1 −1 −1 −1 −1 1 −1 1 1 1 −1 1 −1 −1 −1 1 1 1 1 1 1 −1 1 1 −1 −1 1 −1 1 1 −1 −1 1 |
| | −1 1 −1 −1 1 −1 −1 −1 −1 1 1 −1 1 1 −1 −1 1 −1 1 −1 1 1 1 −1 −1 1 1 −1 1 1 −1 |
| | −1 −1 −1 −1 1 1 −1 1 1 −1 1 −1 1 1 −1 −1 −1 −1 1 1 −1 1 −1 −1 −1 −1 −1 −1 −1 1 |
| | 1 1 −1 1 1 −1 −1 −1 1 −1 −1 1 1 −1 1 1 −1 1 −1 1 1 1 −1 −1 −1 1 −1 −1 1 1 −1 −1 |
| | −1 −1 1 −1 −1 −1 1 1 1 −1 1 −1 1 −1 −1 −1 1 1 1 −1 −1 1 1 1 −1 1 −1 1 1 1 −1 −1 |
| | 1 −1 1 −1 1 −1 1 1 1 1 −1 −1 −1 1 −1 1 1 −1 1 1 1 −1 −1 −1 1 1 −1 −1 −1 −1 1 −1 |
| | 1 1 −1 1 1 1 −1 1 −1 1 1 −1 1 −1 −1 −1 −1 1 1 −1 −1 1 −1 1 1 1 1 −1 1 1 1 1 −1 −1 |
| | 1 1 1 1 −1 1 1 −1 −1 1 1 −1 −1 −1 −1 −1 1 −1 1 1 −1 −1 −1 1 1 1 1 −1 1 −1 −1 −1 |
| | 1 −1 1 −1 −1 1 1 1 −1 −1 −1 −1 1 1 −1 −1 −1 1 1 −1 1 −1 1 1 1 −1 1 1 −1 −1 −1 |
| | −1 −1 1 1 1 1 1 −1 1 1 1 1 1 −1 −1 −1 1 −1 −1 −1 1 −1 1 −1 1 1 −1 −1 −1 1 −1 1 1 |
| | 1 1 1 −1 −1 1 −1 1 1 −1 −1 1 −1 −1 −1 −1 1 −1 1 −1 −1 −1 1 −1 1 1 1 −1 −1 1 1 1 |
| | 1 −1 −1 −1 1 −1 1 −1 1 1 1 1 1 1 −1 −1 −1 −1 −1 −1 1 −1 1 1 −1 1 −1 −1 1 1 −1 |
| | −1 −1 1 −1 1 1 −1 −1 −1 −1 −1 −1 1 −1 −1 1 1 1 −1 1 −1 1 −1 1 1 −1 −1 1 −1 1 |
| | 1 −1 −1 −1 −1 1 −1 −1 −1 −1 −1 1 −1 1 1 −1 −1 1 1 1 1 1 1 1 −1 1 −1 1 −1 1 1 −1 |
| | −1 −1 1 1 −1 1 1 1 −1 1 −1 −1 1 1 1 −1 1 −1 1 −1 1 1 −1 1 1 1 1 −1 −1 −1 1 1 −1 |
| | −1 −1 1 −1 −1 1 1 1 −1 1 −1 1 1 −1 1 −1 1 −1 −1 1 1 1 −1 1 1 1 1 1 1 1 1 −1 −1 1 |
| | 1 −1 −1 −1 1 −1 1 1 1 −1 −1 −1 −1 1 1 −1 1 1 1 1 −1 −1 1 1 −1 −1 −1 1 1 1 1 1 −1 |
| | 1 −1 −1 −1 1 −1 1 1 −1 1 1 1 1 −1 −1 1 1 1 −1 −1 1 1 −1 1 1 1 1 −1 −1 −1 −1 −1 |
| | −1 −1 −1 −1 1 −1 −1 −1 1 −1 1 1 −1 −1 −1 −1 1 −1 1 −1 −1 −1 1 1 1 1 1 −1 1 1 1 |
| | −1 1 −1 −1 −1 −1 −1 −1 1 1 −1 1 −1 −1 1 1 1 −1 −1 −1 −1 −1 1 −1 −1 −1 −1 1 −1 |
| | −1 −1 1 1 1 1 1 −1 1 −1 1 −1 1 −1 1 −1 −1 1 −1 1 1 −1 −1 −1 1 −1 1 −1 −1 1 1 −1 |
| | 1 −1 −1 −1 −1 −1 −1 1 1 1 1 −1 −1 1 −1 1 −1 1 −1 −1 −1 1 1 −1 1 1 1 1 −1 1 −1 1 |
| | −1 −1 1 −1 1 −1 −1 1 −1 1 1 1 1 1 1 −1 −1 1 1 −1 −1 1 1 −1 1 1 −1 −1 −1 1 −1 1 1 |
| | −1 −1 1 −1 −1 −1 1 1 −1 1 −1 1 −1 1 1 1 1 1 −1 1 1 −1 −1 1 1 −1 1 −1 −1 −1 1 1 1 |
| | 1 1 −1 −1 1 1 −1 1 1 −1 −1 1 −1 −1 1 1 1 1 1 1 1 −1 1 1 1 −1 1 1 1 −1 −1 −1 1 −1 |
| | 1 1 −1 −1 −1 1 −1 −1 1 −1 1 1 1 −1 −1 1 1 −1 −1 −1 −1 −1 −1 1 1 1 −1 1 1 1 −1 |
| | −1 1 −1 1 1 1 1 1 1 −1 1 1 1 −1 −1 −1 1 −1 −1 1 −1 −1 −1 −1 −1 −1 −1 −1 1 1 1 1 |
| | −1 −1 −1 −1 1 −1 1 1 −1 −1 −1 1 −1 1 1 −1 1 1 −1 −1 −1 −1 1 −1 −1 −1 1 −1 1 −1 |
| | 1 −1 −1 −1 −1 1 1 1 1 −1 1 1 −1 −1 −1 −1 −1 −1 −1 1 1 1 1 −1 1 −1 −1 1 −1 −1 1 |
| | −1 1 −1 1 −1 1 −1 −1 −1 −1 −1 1 −1 1 −1 −1 1 1 1 −1 1 −1 −1 1 1 1 −1 −1 −1 1 −1 |
| | 1 −1 −1 1 −1 1 1 −1 −1 1 −1 1 −1 1 1 1 1 1 −1 −1 −1 1 −1 1 −1 1 −1 1 1 1 1 1 −1 |
| | −1 1 −1 −1 1 −1 1 1 −1 −1 1 1 −1 1 −1 1 −1 −1 1 1 −1 1 1 1 1 −1 −1 1 −1 −1 |
| | −1 −1 1 −1 1 1 −1 −1 1 −1 −1 1 1 1 −1 1 1 1 −1 −1 1 1 1 1 1 1 −1 1 −1 −1 1 1 −1 |
| | −1 1 1 1 1 1 1 −1 1 1 −1 1 1 −1 1 1 1 −1 1 1 1 −1 −1 1 1 −1 1 1 1 −1 −1 −1 −1 −1 |
| | 1 −1 −1 1 −1 1 −1 −1 1 1 1 −1 1 1 −1 1 1 1 1 −1 −1 −1 −1 1 −1 −1 −1 −1 −1 −1 −1 |
| | 1 1 −1 1 1 1 −1 1 1 1 1 1 1 1 −1 −1 −1 1 1 1 −1 −1 −1 −1 1 1 1 1 −1 1 1 1 −1 −1 |
| | −1 −1 1 −1 1 −1 1 1 −1 1 1 −1 −1 1 −1 −1 −1 −1 1 1 1 −1 −1 −1 −1 −1 1 −1 1 −1 |
| | −1 1 −1 1 −1 1 −1 1 1 1 −1 −1 −1 −1 1 1 1 1 1 1 1 1 −1 1 −1 −1 −1 −1 1 −1 1 −1 |
| | −1 −1 −1 −1 1 1 1 1 −1 1 −1 1 1 −1 −1 1 1 1 −1 −1 −1 1 −1 −1 1 −1 1 −1 −1 −1 −1 |
| | 1 −1 1 −1 1 1 −1 −1 1 −1 −1 1 1 −1 −1 1 1 1 1 −1 1 −1 1 1 1 1 1 1 1 1 1 −1 −1 1 |
| | −1 1 −1 −1 1 1 −1 1 −1 1 −1 −1 −1 −1 −1 1 1 −1 −1 −1 1 −1 −1 −1 −1 1 −1 1 1 −1 |
| | 1 1 −1 −1 1 −1 1 −1 −1 1 1 −1 −1 −1 1 −1 −1 1 −1 −1 −1 1 −1 −1 −1 −1 −1 1 1 −1 |
| | −1 −1 −1 −1 −1 −1 −1 −1 −1 1 −1 −1 1 1 −1 1 1 1 −1 −1 1 1 −1 1 −1 1 −1 −1 −1 1 |
| | −1 1 1 −1 1 −1 1 1 −1 −1 −1 1 1 1 −1 1 1 −1 −1 1 −1 −1 −1 1 −1 1 1 −1 1 1 −1 1 |
| | −1 −1 1 −1 1 −1 1 1 1 −1 1 −1 1 −1 1 −1 1 −1 1 1 −1 1 1 1 −1 −1 −1 −1 1 −1 −1 |
| | −1 1 1 −1 −1 1 −1 1 1 −1 −1 −1 1 1 −1 −1 −1 1 −1 1 1 1 1 −1 −1 −1 1 −1 −1 1 −1 |
| | 1 1 −1 −1 −1 1 1 1 −1 −1 1 −1 −1 1 1 −1 −1 −1 −1 1 1 −1 −1 1 1 −1 −1 1 1 1 −1 |
| | −1 −1 −1 1 −1 1 −1 −1 1 −1 1 1 1 −1 1 1 −1 −1 −1 1 −1 1 1 1 −1 1 −1 −1 1 1 1 1 1 |
| | −1 1 −1 −1 1 −1 −1 1 1 1 −1 1 −1 −1 −1 −1 1 −1 −1 1 −1 −1 −1 1 −1 1 −1 −1 −1 1 |
| | −1 −1 −1 1 −1 −1 −1 −1 1 −1 1 −1 −1 1 1 −1 1 1 −1 −1 −1 −1 1 1 1 −1 1 −1 −1 1 1 |
| | 1 1 −1 −1 1 −1 −1 −1 −1 −1 −1 1 1 −1 1 1 −1 1 1 1 1 −1 −1 1 −1 1 −1 −1 1 −1 −1 |
| | 1 −1 1 1 −1 −1 1 −1 1 1 −1 1 −1 −1 1 −1 1 −1 −1 1 1 −1 1 1 1 −1 −1 −1 1 −1 1 −1 |
| | −1 −1 −1 1 1 −1 1 1 1 1 1 −1 1 1 −1 1 −1 1 −1 1 1 1 −1 −1 −1 1 1 1 1 1 −1 1 1 −1 |
| | −1 1 −1 −1 1 −1 −1 1 1 1 −1 1 1 −1 −1 −1 1 1 −1 1 1 −1 −1 1 −1 −1 −1 1 1 1 1 −1 |
| | 1 −1 −1 1 1 −1 1 −1 1 1 1 −1 −1 −1 −1 −1 −1 1 1 1 −1 −1 1 1 −1 −1 −1 −1 1 −1 1 |
| | 1 1 1 1 1 −1 −1 −1 1 −1 −1 1 −1 −1 1 −1 −1 −1 −1 1 1 1 −1 1 −1 −1 −1 1 1 1 −1 1 |
| | 1 −1 1 −1 −1 −1 −1 −1 1 1 −1 1 1 1 −1 −1 1 1 1 1 −1 1 −1 1 −1 1 1 1 1 −1 1 1 1 −1 |
| | 1 −1 1 1 −1 −1 −1 −1 −1 −1 −1 1 −1 1 1 −1 1 1 −1 1 1 −1 1 −1 1 1 1 1 −1 −1 1 −1 |
| | 1 1 1 1 −1 −1 −1 1 1 −1 1 −1 1 −1 −1 −1 1 1 1 1 −1 1 1 1 1 1 −1 −1 1 1 −1 −1 −1 |
| | −1 −1 1 1 1 1 −1 −1 1 1 1 −1 1 −1 1 −1 1 −1 −1 1 1 1 −1 −1 −1 1 1 1 −1 −1 1 1 1 1 |
| | 1 −1 1 1 −1 −1 −1 −1 −1 1 −1 1 1 1 −1 −1 1 1 −1 1 −1 −1 −1 −1 −1 1 1 1 1 1 1 −1 |
| | 1 1 1 −1 1 −1 1 −1 −1 −1 −1 −1 1 −1 −1 −1 −1 1 1 −1 −1 1 1 −1 1 1 1 1 −1 1 −1 |
| | −1 −1 −1 1 −1 −1 −1 −1 −1 −1 1 1 1 −1 1 −1 1 −1 −1 1 1 1 1 −1 1 1 1 −1 −1 1 −1 |
| | 1 −1 1 1 1 1 1 1 1 −1 −1 −1 −1 1 1 −1 −1 1 −1 1 −1 1 1 −1 1 −1 1 1 1 −1 1 1 1 −1 |
| | −1 −1 −1 −1 1 1 −1 1 −1 1 1 −1 1 −1 1 −1 1 1 1 1 −1 −1 1 1 −1 1 1 1 1 1 −1 −1 −1 |
| | −1 1 −1 −1 1 1 −1 −1 −1 −1 −1 −1 −1 −1 1 −1 1 −1 −1 −1 1 −1 −1 1 1 −1 −1 −1 1 |
| | 1 −1 −1 −1 −1 1 1 1 1 −1 1 −1 1 −1 −1 −1 1 1 −1 −1 −1 1 1 −1 −1 1 1 1 1 1 −1 1 1 |
| | 1 −1 −1 −1 −1 −1 −1 1 −1 1 −1 −1 1 −1 −1 −1 1 −1 1 −1 1 −1 1 −1 −1 1 1 −1 1 −1 |
| | −1 1 −1 −1 −1 1 −1 1 1 1 −1 1 −1 1 1 1 1 1 −1 −1 1 1 −1 1 −1 −1 −1 1 −1 1 1 1 −1 |
| | 1 1 1 1 1 1 −1 −1 −1 −1 1 −1 1 −1 1 −1 −1 1 1 −1 1 1 −1 1 −1 −1 1 1 −1 −1 1 1 −1 |
| | 1 1 1 −1 −1 1 −1 −1 1 −1 1 1 −1 −1 −1 −1 1 1 −1 −1 −1 −1 −1 −1 1 −1 −1 −1 1 1 |
| | −1 1 −1 −1 1 1 1 1 −1 −1 −1 −1 −1 −1 −1 1 −1 1 −1 −1 1 1 −1 −1 1 −1 −1 −1 1 1 1 |
| | −1 −1 1 −1 −1 −1 1 −1 −1 −1 1 1 1 1 −1 1 1 −1 1 1 −1 −1 −1 1 −1 1 −1 −1 −1 1 −1 |
| | 1 −1 1 −1 −1 1 −1 1 1 1 −1 −1 1 −1 −1 −1 −1 −1 1 −1 1 −1 1 −1 1 1 −1 −1 1 −1 −1 |
| | −1 1 −1 −1 1 −1 1 1 1 1 −1 1 1 −1 1 −1 −1 1 −1 1 1 1 1 1 −1 −1 −1 1 1 1 −1 1 −1 |
| | −1 1 1 −1 1 −1 −1 1 1 −1 −1 1 −1 −1 1 1 1 1 −1 1 1 −1 1 −1 1 −1 −1 1 1 −1 −1 1 1 |
| | 1 −1 1 1 −1 1 −1 −1 1 −1 −1 1 1 1 1 1 −1 −1 −1 1 1 −1 1 1 −1 −1 −1 −1 −1 −1 1 |
| | −1 1 1 1 1 −1 −1 1 −1 −1 −1 1 1 −1 1 1 1 −1 1 1 −1 1 1 1 1 1 −1 −1 −1 1 1 −1 −1 1 |
| | −1 −1 −1 1 −1 −1 −1 −1 1 1 1 −1 −1 1 −1 −1 1 −1 −1 −1 −1 −1 −1 1 −1 1 1 1 −1 |
| | −1 −1 1 −1 1 −1 1 −1 −1 1 1 1 1 1 −1 1 1 −1 1 −1 −1 −1 1 1 1 1 −1 −1 −1 1 1 1 1 1 |
| | 1 −1 1 −1 −1 −1 1 −1 −1 1 −1 1 1 −1 1 −1 1 1 1 1 −1 1 1 −1 1 1 −1 1 −1 1 −1 1 1 |
| | −1 −1 −1 −1 1 −1 1 1 −1 −1 1 1 −1 1 1 1 1 1 1 −1 −1 −1 1 1 −1 1 −1 −1 −1 −1 −1 |
| | 1 −1 1 1 1 1 1 1 1 −1 −1 1 −1 1 1 −1 1 1 −1 −1 −1 1 1 −1 −1 −1 −1 −1 1 1 1 −1 −1 |
| | −1 1 1 −1 −1 1 1 1 −1 1 −1 1 1 −1 −1 −1 1 −1 −1 −1 1 1 1 1 1 1 1 −1 1 −1 −1 −1 1 |
| | 1 −1 1 −1 1 −1 −1 1 1 1 1 1 1 1 1 −1 1 1 −1 −1 −1 1 1 1 −1 1 −1 −1 −1 1 −1 1 −1 1 |
| | 1 1 1 −1 1 −1 −1 −1 1 −1 −1 −1 −1 1 1 −1 −1 −1 1 −1 1 1 −1 1 −1 −1 −1 −1 −1 −1 |
| | −1 −1 1 1 −1 1 −1 −1 −1 1 1 −1 −1 1 −1 −1 −1 −1 −1 −1 −1 −1 −1 1 1 1 −1 1 −1 |
| | −1 −1 −1 1 1 −1 1 −1 −1 1 1 −1 −1 −1 −1 −1 1 1 −1 1 −1 −1 1 −1 1 −1 −1 −1 1 −1 |
| | 1 1 −1 −1 −1 1 1 −1 1 −1 1 −1 1 −1 1 1 1 −1 −1 1 −1 1 1 1 −1 1 1 −1 1 −1 1 −1 1 |
| | −1 1 −1 −1 −1 −1 1 1 −1 1 −1 1 1 1 −1 −1 1 −1 −1 −1 1 −1 1 −1 1 1 1 −1 −1 1 −1 |
| | −1 1 1 −1 1 −1 −1 1 1 1 −1 1 −1 −1 −1 1 1 −1 −1 1 1 −1 −1 −1 −1 1 −1 −1 1 1 1 1 |
| | −1 −1 −1 1 1 −1 −1 1 1 −1 −1 1 −1 1 −1 −1 −1 1 1 −1 −1 −1 −1 1 −1 −1 1 −1 1 1 |
| | −1 −1 1 1 1 1 −1 1 1 −1 1 1 1 −1 −1 1 −1 −1 −1 −1 1 1 −1 1 −1 −1 −1 1 −1 −1 −1 |
| | 1 −1 1 −1 −1 1 −1 −1 −1 −1 −1 1 −1 1 1 1 −1 1 1 1 −1 1 1 −1 −1 1 −1 1 1 1 −1 1 |
| | −1 1 1 −1 1 1 −1 −1 −1 1 −1 −1 −1 −1 −1 1 1 1 −1 −1 −1 −1 1 −1 −1 1 −1 1 −1 −1 |
| | −1 1 1 −1 1 −1 −1 1 −1 1 1 −1 −1 1 −1 −1 1 −1 1 −1 1 1 −1 −1 −1 −1 1 1 1 1 −1 |
| | −1 −1 1 −1 −1 1 1 1 1 −1 −1 1 1 1 −1 −1 −1 1 −1 1 1 −1 1 −1 1 −1 −1 −1 −1 1 −1 |
| | 1 −1 −1 1 −1 −1 1 1 −1 1 −1 −1 −1 1 1 −1 1 1 −1 −1 −1 1 −1 −1 1 −1 −1 1 1 −1 −1 |
| | −1 1 −1 1 −1 −1 −1 −1 −1 1 −1 1 1 −1 1 1 1 1 1 −1 1 1 1 1 −1 1 −1 −1 1 1 1 −1 −1 |
| | 1 1 −1 1 −1 1 1 −1 −1 1 −1 −1 1 −1 −1 −1 1 1 −1 1 −1 −1 −1 1 1 1 −1 1 −1 −1 1 |
| | −1 −1 1 −1 −1 −1 1 −1 1 1 −1 −1 1 −1 1 −1 1 1 −1 −1 −1 1 1 1 1 1 1 −1 −1 −1 −1 |
| | −1 1 1 −1 1 1 1 1 −1 1 1 1 −1 −1 1 1 1 −1 1 1 −1 1 1 −1 1 −1 −1 −1 1 1 −1 1 −1 −1 |
| | −1 −1 1 1 −1 1 1 −1 1 1 −1 1 −1 −1 1 1 1 −1 1 1 −1 −1 1 1 1 −1 1 −1 −1 −1 −1 −1 |
| | −1 −1 1 −1 1 −1 1 1 1 −1 −1 −1 −1 −1 1 1 1 1 −1 1 1 1 1 −1 −1 −1 1 1 1 −1 −1 1 |
| | −1 1 1 1 −1 −1 1 −1 1 −1 −1 −1 1 1 1 −1 −1 −1 1 1 −1 1 1 1 1 −1 −1 −1 1 −1 −1 |
| | −1 −1 1 1 −1 1 −1 1 −1 1 −1 −1 1 1 −1 −1 −1 −1 1 −1 1 −1 1 1 1 1 1 −1 −1 −1 −1 |
| | −1 1 −1 1 1 1 1 −1 1 1 −1 −1 −1 −1 1 −1 −1 1 1 −1 1 −1 −1 −1 −1 1 −1 1 1 1 −1 |
| | −1 −1 −1 −1 1 −1 1 1 −1 1 −1 1 1 1 −1 −1 1 1 −1 −1 1 −1 −1 −1 1 −1 1 −1 −1 1 1 |
| | −1 −1 −1 −1 −1 −1 1 −1 1 −1 1 1 −1 −1 −1 −1 −1 1 1 1 −1 1 −1 1 1 −1 1 1 1 −1 −1 |
| | 1 −1 1 −1 −1 1 1 1 1 −1 1 −1 1 −1 −1 1 1 1 −1 −1 1 1 1 1 −1 1 1 1 −1 1 1 −1 1 −1 |
| | −1 1 1 −1 1 1 1 −1 1 −1 1 −1 1 1 −1 −1 1 1 1 −1 1 −1 1 −1 −1 −1 −1 1 1 −1 −1 −1 |
| | 1 1 1 1 −1 1 1 −1 −1 1 −1 −1 −1 −1 −1 1 1 −1 −1 1 −1 −1 −1 −1 1 −1 −1 −1 −1 −1 |
| | 1 1 1 1 −1 −1 −1 1 1 −1 1 1 1 −1 −1 −1 −1 1 1 −1 −1 1 1 1 −1 1 1 1 1 −1 −1 1 1 −1 |
| | 1 −1 1 1 1 −1 1 −1 −1 −1 −1 −1 1 1 1 −1 1 1 −1 1 −1 1 −1 −1 −1 1 −1 −1 1 −1 1 |
| | −1 −1 1 −1 1 −1 1 1 1 1 1 −1 1 −1 −1 −1 1 1 1 1 −1 1 −1 1 1 1 −1 1 1 1 1 −1 −1 −1 |
| | −1 −1 1 −1 −1 −1 1 1 −1 −1 −1 −1 1 1 −1 1 −1 1 −1 −1 −1 −1 1 1 1 −1 −1 1 1 −1 1 |
| | −1 −1 1 −1 −1 1 1 −1 1 1 −1 −1 1 1 1 1 1 1 −1 −1 1 −1 1 1 1 1 1 −1 −1 1 1 1 1 −1 |
| | −1 −1 −1 −1 1 −1 1 −1 1 1 −1 1 −1 −1 −1 1 −1 1 −1 −1 −1 1 1 −1 −1 1 −1 1 −1 −1 |
| | −1 −1 1 −1 −1 −1 1 1 −1 1 1 −1 1 1 1 −1 −1 −1 1 −1 −1 −1 −1 −1 −1 −1 1 −1 −1 1 |
| | 1 1 1 1 1 −1 1 1 1 1 1 −1 1 −1 1 −1 −1 1 1 −1 −1 −1 1 1 −1 1 −1 −1 1 1 −1 1 −1 −1 |
| | −1 1 −1 −1 1 1 −1 1 −1 1 1 −1 1 −1 −1 −1 1 1 1 −1 −1 −1 −1 1 −1 1 1 −1 1 −1 1 |
| | −1 1 −1 −1 1 −1 −1 −1 −1 −1 −1 −1 1 1 1 1 1 1 −1 −1 1 1 −1 1 1 1 −1 1 −1 −1 −1 |
| | 1 1 −1 1 1 1 −1 −1 1 −1 1 1 −1 1 1 1 −1 −1 1 1 1 −1 −1 1 −1 1 1 1 1 −1 1 −1 1 1 |
| | −1 −1 −1 1 1 −1 −1 1 1 −1 1 1 −1 1 −1 1 −1 1 −1 −1 −1 −1 −1 −1 −1 1 −1 −1 −1 1 |
| | 1 1 1 −1 −1 1 −1 1 1 1 −1 −1 −1 −1 1 −1 −1 1 1 1 −1 −1 −1 −1 1 −1 −1 −1 −1 1 −1 |
| | −1 1 1 1 1 1 −1 −1 1 1 1 −1 1 −1 −1 −1 1 −1 −1 −1 1 1 1 −1 −1 1 1 −1 −1 1 −1 1 |
| | −1 1 −1 1 1 −1 1 −1 −1 −1 −1 −1 1 −1 −1 1 1 1 1 −1 1 −1 1 1 −1 1 1 1 1 −1 1 −1 1 |
| | 1 −1 1 −1 1 1 −1 1 1 1 1 1 1 −1 1 1 1 1 −1 −1 1 −1 1 1 −1 1 −1 −1 −1 −1 1 −1 −1 |
| | −1 1 −1 −1 1 1 −1 −1 1 1 1 −1 −1 1 −1 1 −1 1 1 −1 1 1 1 1 1 −1 −1 1 1 1 −1 −1 −1 |
| | −1 −1 1 1 −1 −1 −1 1 1 −1 −1 −1 1 1 1 1 1 1 1 −1 −1 −1 −1 −1 1 −1 −1 1 1 1 −1 |
| | −1 1 −1 1 −1 −1 1 −1 1 1 −1 1 1 1 −1 1 1 1 1 −1 1 1 −1 −1 1 1 1 −1 −1 −1 −1 −1 |
| | −1 1 −1 −1 −1 −1 1 −1 1 −1 1 1 1 −1 1 −1 −1 −1 1 −1 1 1 1 1 1 1 1 1 −1 1 −1 1 −1 |
| | −1 1 −1 −1 −1 −1 1 −1 −1 1 1 −1 1 1 −1 −1 −1 1 1 1 1 −1 −1 −1 −1 −1 1 1 1 −1 1 |
| | 1 1 1 −1 1 −1 1 −1 1 1 −1 1 −1 1 1 −1 −1 1 1 1 1 −1 −1 1 −1 1 1 −1 −1 −1 −1 −1 |
| | −1 −1 −1 −1 1 1 −1 −1 1 −1 −1 1 −1 1 −1 −1 1 −1 −1 −1 1 1 1 −1 1 −1 −1 −1 −1 |
| | −1 1 −1 1 −1 1 1 1 1 −1 −1 −1 −1 −1 1 1 −1 −1 1 1 1 −1 −1 1 1 1 −1 1 1 1 1 1 −1 1 |
| | 1 −1 −1 −1 1 −1 1 −1 1 −1 1 −1 1 1 1 −1 1 1 −1 1 1 −1 −1 1 −1 −1 1 −1 1 1 1 1 −1 |
| | −1 1 −1 1 −1 1 1 −1 −1 1 1 1 1 1 −1 1 −1 1 −1 −1 −1 1 −1 −1 −1 −1 1 −1 −1 −1 −1 |
| | 1 1 1 1 1 1 −1 −1 −1 1 −1 1 1 −1 −1 1 1 −1 −1 1 1 1 1 −1 −1 −1 1 1 1 −1 1 1 −1 1 |
| | 1 −1 −1 −1 −1 −1 1 −1 −1 1 1 −1 −1 −1 1 −1 −1 −1 −1 −1 −1 1 1 −1 −1 1 −1 1 1 |
| | −1 1 −1 1 1 −1 1 −1 1 1 1 1 1 1 1 −1 1 −1 −1 1 1 1 −1 1 1 1 −1 1 1 1 1 1 −1 1 −1 |
| | −1 −1 −1 1 1 1 −1 −1 −1 1 −1 1 −1 1 1 −1 1 1 1 −1 1 −1 −1 1 −1 1 −1 1 −1 −1 −1 |
| | 1 −1 −1 1 1 1 −1 −1 1 1 1 −1 −1 1 1 1 1 1 1 1 1 −1 −1 1 −1 −1 −1 −1 1 1 1 1 −1 −1 |
| | −1 −1 −1 −1 1 1 −1 1 −1 1 1 1 1 −1 1 −1 −1 1 1 −1 −1 −1 1 1 1 1 −1 −1 1 −1 −1 1 |
| | 1 −1 −1 1 −1 1 1 −1 1 1 1 1 −1 1 1 1 1 −1 1 1 1 1 1 1 1 1 1 −1 1 1 −1 1 −1 1 1 1 1 |
| | 1 −1 1 −1 1 −1 1 1 1 −1 −1 1 1 1 1 1 −1 −1 1 −1 −1 −1 1 −1 1 1 1 1 1 −1 1 1 −1 1 |
| | 1 1 −1 1 1 −1 −1 −1 1 1 1 1 1 −1 −1 −1 −1 −1 1 1 1 1 1 1 1 1 1 1 −1 −1 −1 1 1 −1 |
| | −1 −1 −1 −1 −1 1 1 −1 −1 1 1 1 1 −1 1 1 1 1 1 1 1 1 1 −1 1 −1 −1 1 1 1 1 1 1 −1 |
| | −1 −1 1 1 1 1 −1 −1 −1 1 −1 1 1 1 1 1 1 −1 1 −1 1 −1 −1 −1 −1 −1 −1 −1 −1 −1 −1 |
| | −1 1 −1 1 1 1 −1 1 −1 1 −1 1 1 −1 1 1 1 1 1 −1 −1 −1 −1 −1 −1 −1 1 1 1 −1 −1 1 |
| | −1 −1 −1 −1 −1 1 −1 1 1 1 1 1 −1 1 −1 −1 1 1 1 1 1 1 1 −1 −1 1 1 −1 1 −1 1 |
| | −1 1 −1 1 −1 1 −1 −1 1 1 1 1 −1 −1 1 1 −1 −1 −1 −1 1 1 1 1 1 1 −1 1 −1 1 −1 1 −1 |
| | −1 −1 −1 1 −1 −1 1 −1 1 −1 1 −1 1 1 −1 −1 −1 −1 −1 −1 1 1 −1 1 1 1 1 1 1 1 1 −1 |
| | 1 1 1 −1 −1 1 1 −1 −1 1 1 −1 −1 1 −1 −1 −1 −1 −1 1 −1 −1 −1 1 −1 1 −1 −1 −1 −1 |
| | −1 −1 −1 1 1 −1 −1 1 1 −1 1 −1 1 1 −1 1 1 −1 −1 1 1 −1 −1 −1 1 −1 1 −1 1 −1 −1 |
| | −1 1 1 1 1 1 1 1 1 1 −1 −1 −1 −1 1 −1 −1 −1 1 −1 −1 −1 1 −1 −1 1 −1 1 −1 1 1 −1 |
| | 1 −1 −1 1 1 −1 1 −1 1 −1 1 −1 −1 −1 1 −1 −1 −1 1 1 −1 −1 −1 1 1 1 −1 1 1 1 −1 1 |
| | −1 −1 1 1 −1 −1 1 −1 1 1 1 1 1 1 1 1 1 1 −1 1 −1 1 1 −1 1 −1 −1 1 −1 1 1 −1 1 1 |
| | −1 −1 1 1 1 −1 −1 1 −1 −1 −1 1 1 −1 −1 1 1 −1 1 −1 −1 1 −1 1 1 1 −1 1 −1 −1 −1 |
| | −1 1 1 1 1 −1 −1 1 −1 −1 −1 1 −1 −1 1 1 1 1 1 1 1 1 1 1 1 −1 −1 1 1 1 −1 −1 1 −1 |
| | −1 1 1 1 −1 −1 −1 1 −1 −1 −1 −1 1 −1 −1 1 −1 1 1 1 −1 1 1 1 −1 −1 1 −1 −1 1 1 1 |
| | 1 −1 −1 1 −1 1 −1 −1 −1 −1 −1 1 −1 −1 1 −1 1 1 −1 1 1 1 1 1 1 1 1 1 1 1 1 −1 1 1 |
| | 1 1 −1 1 1 −1 1 1 1 1 −1 1 −1 −1 1 −1 1 −1 −1 1 −1 −1 1 1 1 1 −1 −1 −1 −1 1 −1 |
| | −1 1 −1 −1 −1 −1 −1 1 −1 −1 1 1 −1 1 −1 1 −1 −1 1 −1 −1 1 1 1 |
| 8 | −1 −1 −1 −1 −1 −1 −1 −1 −1 −1 −1 −1 −1 1 1 −1 −1 1 1 1 −1 −1 −1 1 −1 1 −1 1 |
| | −1 −1 1 −1 −1 −1 −1 1 1 −1 −1 1 1 1 −1 1 −1 −1 −1 −1 −1 1 1 −1 1 1 1 1 1 −1 −1 |
| | −1 1 −1 1 1 −1 −1 −1 1 −1 1 −1 1 −1 1 −1 1 1 1 1 1 −1 1 −1 −1 1 1 −1 1 −1 1 1 −1 |
| | 1 1 1 1 −1 −1 −1 −1 −1 −1 1 −1 1 1 1 1 −1 1 1 −1 −1 −1 −1 1 −1 −1 1 1 −1 1 1 −1 |
| | 1 −1 −1 1 1 1 −1 1 −1 1 1 −1 −1 1 1 1 1 −1 −1 1 1 1 −1 −1 1 1 −1 −1 −1 −1 1 −1 1 |
| | 1 −1 1 −1 −1 −1 1 −1 −1 1 −1 −1 −1 1 −1 −1 1 −1 −1 −1 −1 −1 1 1 1 −1 −1 1 −1 1 |
| | −1 −1 1 1 −1 1 1 1 1 1 1 −1 −1 1 −1 1 −1 1 −1 1 −1 1 1 −1 1 −1 −1 −1 −1 −1 −1 1 |
| | −1 −1 1 −1 −1 1 −1 1 −1 −1 −1 −1 −1 1 −1 1 1 1 1 1 −1 −1 1 1 1 −1 −1 1 −1 −1 1 |
| | −1 1 1 −1 −1 1 −1 −1 1 1 1 −1 1 −1 −1 1 −1 −1 1 1 −1 −1 −1 1 −1 −1 1 −1 −1 1 −1 |
| | −1 1 1 1 1 1 1 1 −1 1 −1 1 1 −1 −1 1 −1 −1 −1 1 1 −1 1 −1 1 −1 −1 1 −1 −1 −1 −1 |
| | −1 1 1 −1 −1 1 1 1 1 −1 1 1 1 1 −1 −1 −1 −1 −1 1 1 1 1 −1 1 1 1 1 1 1 1 1 1 −1 1 |
| | −1 −1 −1 −1 1 1 1 1 1 −1 −1 1 1 1 −1 1 1 1 −1 −1 −1 1 −1 −1 −1 −1 1 1 −1 −1 −1 |
| | −1 −1 1 −1 1 −1 1 1 −1 −1 1 −1 1 1 1 −1 −1 −1 1 −1 1 1 −1 −1 1 1 1 1 1 1 −1 −1 |
| | −1 1 −1 −1 −1 −1 1 −1 −1 1 −1 1 −1 1 1 1 −1 −1 −1 1 1 −1 1 1 −1 −1 −1 −1 −1 −1 |
| | −1 −1 1 1 −1 1 −1 −1 −1 1 1 −1 −1 1 1 1 1 −1 −1 1 −1 1 1 −1 −1 1 −1 1 −1 −1 −1 |
| | 1 −1 −1 1 −1 −1 1 1 1 −1 −1 −1 −1 1 −1 −1 −1 −1 −1 1 1 −1 −1 −1 1 −1 1 1 1 1 −1 |
| | 1 −1 1 1 1 1 −1 −1 1 −1 1 1 1 1 −1 1 −1 1 −1 1 −1 −1 1 1 −1 −1 1 1 −1 1 −1 1 −1 1 |
| | 1 1 1 1 1 −1 1 1 −1 −1 −1 −1 1 1 −1 −1 1 1 1 1 1 1 −1 1 −1 −1 −1 1 −1 −1 −1 −1 |
| | −1 −1 1 −1 1 −1 −1 1 1 1 −1 1 1 1 1 −1 −1 1 −1 −1 1 1 1 −1 1 1 −1 −1 −1 1 1 1 1 |
| | −1 −1 −1 1 1 −1 1 1 1 1 1 1 1 1 −1 1 −1 1 1 1 −1 −1 −1 1 −1 1 −1 −1 1 1 −1 1 1 −1 |
| | 1 −1 1 1 −1 1 1 1 −1 −1 1 −1 1 −1 −1 −1 −1 1 −1 −1 −1 1 −1 −1 −1 1 1 −1 1 −1 1 |
| | 1 −1 −1 −1 1 −1 −1 1 1 1 1 1 −1 −1 −1 −1 −1 −1 −1 1 1 −1 1 −1 1 −1 −1 1 1 −1 1 |
| | −1 1 1 1 1 −1 1 −1 −1 −1 1 −1 −1 1 −1 1 −1 −1 −1 1 1 −1 1 −1 −1 1 −1 −1 −1 1 1 |
| | 1 1 −1 −1 −1 1 −1 −1 −1 1 −1 1 1 −1 1 1 1 −1 1 −1 −1 −1 −1 1 1 1 −1 1 1 −1 −1 1 |
| | 1 1 1 1 −1 1 1 1 −1 1 −1 1 1 1 1 −1 1 −1 1 −1 −1 −1 1 1 −1 −1 −1 −1 1 −1 −1 1 −1 |
| | 1 −1 −1 1 −1 −1 1 −1 1 −1 −1 1 −1 1 1 1 1 1 −1 1 1 1 1 −1 −1 −1 1 −1 −1 1 −1 1 |
| | −1 −1 1 1 −1 −1 −1 −1 −1 −1 −1 −1 1 −1 −1 −1 −1 1 −1 1 −1 −1 −1 −1 −1 −1 −1 1 |
| | 1 1 1 −1 1 −1 −1 −1 −1 −1 −1 1 −1 1 1 1 −1 −1 −1 1 1 −1 −1 1 1 −1 1 −1 −1 1 −1 |
| | −1 −1 −1 1 −1 1 1 −1 −1 −1 −1 −1 1 −1 1 −1 −1 1 1 −1 −1 −1 1 −1 1 −1 1 1 −1 1 |
| | −1 −1 −1 1 −1 1 1 1 −1 1 1 −1 1 1 −1 1 1 1 1 −1 −1 1 1 1 1 −1 1 1 −1 −1 1 1 1 1 |
| | −1 −1 −1 1 −1 −1 1 1 1 1 −1 −1 1 −1 1 −1 −1 1 1 1 1 −1 1 −1 1 1 1 −1 1 1 −1 1 −1 |
| | 1 −1 −1 −1 −1 −1 1 −1 1 −1 1 −1 1 1 −1 1 −1 1 −1 1 −1 1 1 −1 1 1 −1 1 −1 1 −1 1 |
| | 1 −1 1 1 1 −1 1 −1 1 −1 1 1 −1 1 −1 −1 1 −1 1 −1 −1 −1 −1 −1 −1 −1 −1 1 −1 1 1 |
| | 1 −1 1 −1 −1 1 1 −1 1 −1 −1 1 1 1 −1 1 1 1 −1 −1 1 1 1 −1 1 −1 1 −1 −1 −1 1 1 1 |
| | −1 1 −1 −1 −1 −1 −1 −1 1 1 1 −1 1 1 −1 −1 −1 1 −1 1 −1 −1 1 −1 1 −1 −1 1 −1 −1 |
| | −1 −1 −1 −1 1 1 −1 −1 1 1 −1 −1 1 −1 −1 −1 1 1 1 −1 1 −1 1 1 1 1 1 −1 1 −1 1 1 |
| | −1 −1 −1 −1 1 −1 −1 1 −1 −1 −1 1 1 1 −1 1 1 1 −1 1 −1 1 −1 −1 −1 1 −1 1 1 1 1 |
| | −1 −1 1 −1 −1 −1 −1 −1 1 −1 −1 −1 1 1 1 −1 1 1 −1 −1 −1 −1 −1 −1 1 1 −1 −1 |
| | −1 −1 −1 1 1 1 1 1 −1 −1 −1 −1 −1 1 −1 −1 1 1 1 −1 −1 −1 −1 −1 −1 1 −1 1 −1 1 |
| | −1 −1 −1 1 −1 1 −1 −1 −1 1 1 −1 −1 1 1 −1 1 1 −1 −1 −1 1 −1 −1 −1 −1 1 −1 1 1 1 |
| | 1 1 1 1 −1 −1 −1 1 −1 −1 1 −1 −1 −1 1 1 −1 −1 −1 1 −1 −1 1 1 1 −1 1 1 −1 1 −1 |
| | −1 1 −1 1 −1 1 −1 1 −1 1 −1 −1 −1 −1 1 −1 −1 1 −1 1 1 1 −1 1 1 −1 −1 −1 1 −1 −1 |
| | −1 1 1 1 1 −1 1 1 −1 1 1 1 1 1 −1 1 1 1 1 1 −1 1 1 1 −1 1 1 1 −1 1 −1 −1 1 1 1 −1 1 |
| | 1 −1 −1 1 1 −1 1 −1 −1 −1 1 1 1 1 −1 −1 −1 −1 −1 1 −1 −1 −1 1 −1 −1 1 −1 −1 1 |
| | −1 1 1 −1 1 −1 1 1 −1 −1 1 1 −1 −1 1 1 −1 −1 1 1 1 1 −1 −1 −1 −1 −1 1 1 −1 1 1 1 |
| | −1 1 1 −1 1 1 −1 −1 1 −1 1 1 −1 1 −1 1 1 1 −1 −1 1 1 −1 1 −1 −1 −1 −1 −1 −1 −1 |
| | 1 1 −1 1 1 1 1 −1 −1 1 −1 −1 −1 1 −1 −1 −1 1 −1 1 −1 1 −1 −1 −1 1 1 1 1 −1 1 1 1 |
| | 1 −1 1 −1 1 −1 −1 1 1 −1 −1 1 −1 −1 −1 −1 −1 −1 1 −1 1 1 −1 −1 1 −1 −1 1 −1 1 1 |
| | 1 1 −1 1 1 −1 1 −1 1 1 1 −1 1 −1 −1 1 −1 1 −1 1 1 −1 1 −1 1 1 −1 1 −1 −1 1 1 −1 1 |
| | 1 1 1 −1 1 1 −1 −1 −1 1 1 1 −1 −1 1 −1 −1 1 −1 −1 1 1 −1 −1 −1 −1 −1 1 1 1 −1 1 |
| | 1 −1 1 −1 −1 −1 −1 −1 −1 −1 −1 1 1 1 −1 1 1 1 −1 1 1 1 −1 1 1 −1 −1 1 1 −1 1 1 |
| | −1 1 1 −1 1 1 1 −1 −1 1 1 −1 1 1 1 1 1 1 1 −1 −1 −1 −1 −1 1 1 1 −1 −1 −1 1 −1 1 1 |
| | −1 1 1 −1 1 −1 1 1 1 −1 −1 −1 1 1 1 1 −1 −1 1 −1 −1 1 −1 −1 1 −1 −1 1 −1 1 −1 1 |
| | −1 1 −1 −1 −1 1 −1 1 1 −1 1 1 −1 −1 −1 −1 1 −1 −1 −1 1 1 1 −1 −1 1 1 −1 1 −1 −1 |
| | 1 −1 1 −1 1 1 1 1 1 1 −1 −1 1 1 −1 1 −1 1 −1 −1 −1 −1 −1 −1 −1 −1 −1 −1 −1 1 −1 |
| | −1 1 1 −1 1 −1 1 −1 1 1 −1 1 −1 1 1 1 1 1 −1 −1 1 −1 −1 1 1 −1 1 −1 −1 1 1 −1 −1 |
| | −1 1 −1 −1 −1 −1 1 1 1 −1 1 −1 1 1 −1 −1 −1 1 −1 1 1 −1 1 −1 1 −1 1 −1 −1 1 1 1 |
| | −1 −1 1 1 1 −1 −1 −1 1 −1 −1 −1 −1 −1 1 1 −1 1 −1 −1 −1 −1 1 1 −1 −1 1 1 −1 −1 |
| | −1 −1 1 −1 −1 1 1 1 1 −1 −1 −1 −1 −1 −1 1 1 1 −1 1 −1 −1 1 −1 −1 −1 1 1 −1 1 1 |
| | −1 1 1 −1 1 −1 1 1 −1 −1 1 −1 −1 1 1 −1 −1 −1 −1 1 1 −1 1 1 1 1 1 1 −1 1 1 1 1 1 |
| | 1 −1 −1 −1 1 −1 1 −1 1 1 1 −1 1 1 1 −1 −1 −1 −1 1 1 1 1 −1 1 1 1 −1 1 −1 1 −1 1 |
| | −1 −1 −1 −1 1 1 −1 −1 −1 −1 1 1 1 1 1 1 1 1 −1 1 1 −1 −1 −1 1 1 −1 −1 1 1 1 −1 1 |
| | 1 −1 1 −1 1 1 1 1 1 1 −1 −1 −1 1 1 1 1 1 −1 1 −1 −1 1 1 1 1 1 1 −1 −1 1 −1 1 1 1 1 |
| | 1 1 1 1 1 1 −1 1 1 1 1 1 −1 −1 1 −1 −1 −1 1 1 1 1 −1 1 −1 −1 −1 1 −1 1 1 1 1 1 −1 |
| | −1 −1 1 −1 −1 1 1 −1 1 1 −1 −1 −1 1 1 −1 1 −1 −1 −1 1 −1 1 1 −1 −1 −1 1 1 1 1 1 |
| | 1 1 −1 −1 1 1 −1 −1 1 −1 1 1 1 −1 1 1 −1 1 −1 −1 −1 1 −1 1 −1 1 1 1 −1 −1 1 −1 |
| | −1 1 −1 −1 −1 1 1 −1 1 −1 −1 −1 1 1 1 −1 −1 1 −1 1 −1 1 1 −1 −1 −1 1 1 −1 1 1 1 |
| | 1 −1 1 −1 1 1 1 −1 −1 1 1 1 1 1 −1 1 −1 −1 1 −1 1 −1 1 −1 −1 −1 −1 −1 1 −1 −1 |
| | −1 −1 −1 −1 1 −1 −1 −1 1 1 −1 1 −1 −1 1 1 −1 1 1 −1 1 1 1 −1 −1 −1 1 1 1 −1 1 1 |
| | −1 1 1 1 1 1 1 1 −1 1 −1 1 −1 −1 1 1 1 −1 −1 −1 1 −1 −1 1 −1 1 1 −1 −1 1 1 −1 −1 |
| | 1 −1 −1 1 1 −1 1 1 1 −1 −1 1 1 −1 −1 1 −1 1 −1 1 1 1 −1 −1 1 1 −1 −1 −1 1 −1 1 |
| | −1 −1 1 1 1 1 −1 −1 −1 −1 1 −1 −1 1 −1 −1 1 1 −1 1 1 1 1 −1 −1 1 1 −1 1 1 1 −1 |
| | −1 −1 −1 1 1 −1 1 1 1 −1 1 −1 −1 −1 1 1 −1 1 1 1 1 1 −1 1 −1 −1 −1 −1 1 −1 1 −1 |
| | 1 1 −1 1 −1 1 −1 −1 −1 −1 1 1 1 1 1 1 −1 −1 1 −1 −1 1 −1 1 −1 1 1 −1 1 1 1 −1 −1 |
| | −1 −1 −1 −1 1 −1 −1 −1 −1 −1 1 −1 1 1 1 −1 1 1 −1 −1 1 1 1 −1 1 1 1 −1 1 −1 −1 |
| | −1 1 −1 −1 −1 1 −1 1 1 1 1 −1 1 1 1 −1 1 −1 −1 −1 −1 −1 1 −1 −1 −1 1 −1 1 1 1 |
| | −1 −1 −1 1 −1 −1 1 1 −1 −1 1 1 −1 1 1 1 1 1 −1 1 1 −1 1 −1 −1 −1 1 1 1 1 1 −1 1 |
| | −1 1 1 −1 1 −1 1 1 1 −1 1 1 −1 −1 −1 −1 −1 1 −1 −1 1 1 −1 −1 1 −1 1 −1 −1 −1 −1 |
| | 1 1 −1 1 1 1 −1 −1 −1 1 −1 −1 1 −1 −1 1 1 −1 −1 1 −1 1 1 −1 1 −1 −1 1 −1 −1 1 1 |
| | 1 1 1 −1 1 1 1 1 1 1 1 −1 1 1 1 1 −1 −1 1 1 1 −1 −1 −1 1 1 −1 1 −1 1 1 1 1 1 −1 1 1 |
| | 1 −1 −1 1 −1 −1 −1 −1 −1 −1 1 1 1 −1 −1 1 1 −1 1 1 −1 −1 −1 −1 −1 1 −1 1 1 −1 |
| | −1 1 1 −1 −1 −1 −1 1 1 −1 −1 1 −1 1 −1 1 −1 −1 1 1 −1 −1 −1 1 1 1 1 1 −1 −1 1 1 |
| | −1 −1 −1 1 −1 −1 −1 1 1 −1 1 1 1 −1 −1 1 −1 1 1 −1 1 −1 −1 −1 −1 1 1 −1 1 1 −1 |
| | −1 1 −1 −1 −1 −1 −1 −1 −1 −1 −1 1 1 −1 1 1 −1 1 1 −1 −1 −1 −1 1 1 −1 1 1 −1 1 |
| | −1 1 1 1 1 −1 1 1 −1 1 1 1 −1 1 1 1 −1 1 1 −1 −1 1 −1 −1 1 −1 −1 −1 −1 −1 1 −1 1 |
| | 1 −1 −1 −1 1 1 −1 1 −1 1 −1 −1 −1 −1 1 −1 1 −1 1 −1 −1 −1 −1 −1 −1 −1 1 −1 1 |
| | −1 −1 −1 −1 −1 1 −1 −1 1 −1 1 −1 −1 −1 −1 1 1 1 1 −1 1 1 −1 −1 −1 −1 −1 −1 1 1 |
| | −1 −1 1 −1 −1 1 1 1 −1 −1 −1 1 1 1 −1 1 −1 −1 −1 1 −1 1 1 −1 1 −1 −1 1 −1 1 1 |
| | −1 1 −1 1 −1 −1 1 1 −1 −1 −1 −1 1 −1 1 −1 −1 −1 −1 1 −1 1 1 −1 1 1 1 1 −1 1 1 1 |
| | 1 1 −1 −1 −1 −1 1 −1 −1 1 1 −1 −1 1 1 1 1 −1 1 −1 1 −1 −1 1 −1 −1 1 1 1 −1 −1 1 |
| | −1 −1 −1 1 −1 −1 1 1 1 1 1 1 −1 1 −1 1 −1 −1 −1 1 −1 −1 1 −1 1 1 −1 1 1 −1 −1 1 |
| | 1 −1 1 1 1 1 −1 −1 −1 1 1 1 −1 1 −1 1 −1 −1 −1 −1 1 −1 −1 −1 −1 −1 1 −1 −1 1 −1 |
| | −1 −1 1 −1 1 1 1 −1 1 −1 −1 −1 1 1 1 1 −1 1 −1 1 −1 −1 −1 −1 1 1 −1 1 −1 1 1 −1 |
| | 1 1 −1 1 1 −1 1 −1 −1 1 1 −1 −1 −1 −1 −1 1 −1 1 1 1 −1 −1 1 1 −1 −1 1 1 1 1 1 −1 |
| | 1 −1 1 1 1 1 1 1 −1 1 −1 −1 1 −1 1 1 1 1 −1 1 −1 −1 −1 −1 −1 1 1 1 1 −1 1 −1 1 −1 |
| | 1 −1 1 1 −1 −1 1 1 1 1 1 −1 −1 1 −1 −1 −1 −1 1 −1 1 1 1 −1 1 −1 1 1 −1 −1 −1 −1 |
| | −1 −1 1 1 1 −1 −1 −1 1 1 1 −1 −1 −1 1 −1 −1 −1 1 −1 −1 1 1 1 −1 1 −1 −1 −1 −1 1 |
| | 1 −1 −1 −1 1 1 −1 1 −1 1 1 −1 1 −1 −1 −1 1 1 1 −1 1 1 1 1 1 1 1 1 −1 −1 −1 −1 1 |
| | −1 −1 −1 1 1 −1 −1 1 1 −1 −1 1 1 −1 1 1 −1 1 −1 −1 −1 1 −1 −1 −1 −1 1 −1 −1 −1 |
| | −1 −1 −1 −1 1 1 1 −1 −1 −1 −1 1 −1 −1 1 −1 1 1 −1 −1 −1 1 1 −1 −1 −1 −1 −1 1 |
| | −1 −1 −1 −1 1 1 −1 1 1 1 1 −1 1 1 1 −1 1 1 −1 1 −1 1 1 −1 1 −1 1 1 −1 −1 −1 1 1 |
| | −1 −1 1 −1 1 1 1 −1 −1 1 1 1 1 −1 −1 −1 −1 1 1 −1 −1 −1 1 1 1 1 1 1 −1 −1 1 1 −1 |
| | −1 −1 −1 −1 1 −1 −1 1 −1 −1 1 1 1 1 −1 1 −1 −1 −1 −1 1 −1 −1 −1 −1 1 1 1 −1 −1 |
| | −1 −1 1 1 −1 −1 −1 −1 1 −1 1 −1 1 −1 1 1 1 1 1 1 1 1 −1 −1 1 −1 −1 −1 1 −1 1 −1 |
| | −1 −1 −1 −1 1 1 −1 −1 −1 −1 −1 −1 1 −1 1 −1 −1 −1 1 −1 −1 −1 1 1 −1 −1 −1 −1 |
| | 1 1 −1 −1 −1 −1 −1 −1 −1 −1 −1 −1 1 −1 1 1 −1 −1 −1 −1 1 1 1 1 1 −1 1 −1 −1 −1 |
| | 1 −1 1 −1 1 −1 1 1 −1 −1 −1 −1 −1 −1 −1 1 −1 −1 1 −1 1 −1 1 −1 1 1 −1 1 1 1 1 1 |
| | 1 1 1 1 1 1 1 −1 1 −1 1 −1 1 1 −1 1 1 −1 −1 −1 −1 −1 −1 1 −1 −1 1 1 1 −1 1 −1 1 |
| | −1 1 1 −1 −1 −1 1 1 1 1 −1 1 −1 −1 1 1 1 1 −1 1 1 −1 −1 −1 1 −1 1 1 −1 −1 −1 −1 |
| | −1 −1 −1 −1 −1 1 1 1 1 −1 −1 −1 1 −1 1 −1 −1 −1 −1 1 −1 −1 1 1 1 −1 1 1 1 1 1 |
| | −1 −1 −1 1 1 1 −1 −1 1 −1 1 1 1 −1 −1 1 −1 1 −1 −1 1 −1 −1 −1 1 −1 1 1 −1 −1 −1 |
| | −1 1 −1 1 −1 1 1 1 −1 1 −1 1 1 −1 1 −1 1 −1 1 1 1 −1 −1 −1 1 −1 −1 −1 1 1 −1 −1 |
| | 1 −1 −1 1 1 −1 −1 1 −1 −1 1 1 1 1 −1 1 1 −1 1 −1 −1 −1 −1 1 −1 1 −1 −1 1 1 1 1 1 |
| | −1 1 −1 −1 −1 −1 −1 −1 −1 −1 −1 1 −1 −1 −1 1 1 1 1 1 −1 −1 1 −1 −1 1 −1 −1 −1 |
| | −1 1 1 1 1 −1 −1 −1 1 1 1 1 −1 1 −1 1 1 −1 1 −1 −1 1 −1 −1 −1 1 −1 1 −1 −1 1 −1 |
| | 1 1 −1 −1 −1 1 −1 −1 1 −1 1 −1 1 1 −1 −1 1 −1 −1 1 −1 −1 1 −1 1 1 1 1 1 1 −1 −1 |
| | −1 −1 1 −1 1 −1 −1 1 1 −1 1 −1 −1 −1 −1 −1 1 −1 −1 1 1 1 1 −1 1 −1 1 −1 1 1 1 |
| | −1 −1 1 1 1 −1 1 1 1 1 −1 1 1 1 −1 −1 1 1 1 1 1 1 1 1 −1 −1 −1 1 1 1 −1 1 1 1 1 −1 |
| | 1 −1 1 1 −1 −1 1 1 −1 1 1 −1 −1 1 1 1 −1 1 −1 1 1 1 1 −1 −1 −1 −1 −1 1 −1 1 −1 |
| | −1 −1 1 1 −1 1 1 −1 −1 −1 1 −1 1 −1 1 1 1 1 1 −1 1 1 −1 −1 1 1 1 −1 −1 1 −1 −1 |
| | −1 −1 −1 1 1 −1 1 1 −1 1 −1 −1 1 −1 1 1 1 1 1 1 1 −1 1 −1 −1 −1 1 1 −1 1 −1 1 −1 |
| | 1 1 1 −1 1 −1 −1 −1 1 −1 1 −1 −1 −1 −1 1 1 −1 −1 1 −1 −1 1 −1 1 1 −1 1 1 1 −1 |
| | −1 1 1 1 1 −1 1 −1 1 1 −1 −1 −1 1 1 1 −1 −1 −1 −1 1 1 1 −1 1 −1 −1 −1 1 1 1 −1 |
| | −1 −1 −1 −1 −1 −1 1 −1 1 −1 1 −1 1 −1 −1 −1 −1 −1 −1 1 1 1 1 1 −1 −1 1 −1 1 1 1 |
| | −1 1 −1 1 −1 1 1 1 1 1 −1 −1 −1 1 1 −1 −1 1 1 1 1 1 −1 −1 −1 −1 1 −1 1 1 −1 −1 1 |
| | 1 1 −1 1 −1 −1 1 −1 1 1 −1 −1 1 −1 1 1 −1 1 1 1 −1 1 1 −1 1 −1 −1 1 1 1 1 1 1 1 |
| | −1 −1 −1 −1 1 1 −1 1 1 −1 −1 −1 −1 1 −1 1 −1 −1 1 −1 −1 −1 −1 1 −1 −1 1 1 −1 1 |
| | −1 −1 −1 −1 1 1 1 −1 −1 1 1 −1 −1 1 1 −1 1 −1 −1 −1 −1 1 −1 1 1 −1 −1 1 −1 1 1 |
| | 1 1 −1 1 1 1 1 1 1 −1 1 −1 −1 −1 −1 −1 1 −1 1 −1 −1 −1 −1 1 1 1 −1 −1 −1 1 1 −1 |
| | −1 1 −1 −1 −1 −1 1 1 −1 1 −1 −1 −1 1 −1 −1 1 1 −1 1 1 1 −1 1 1 −1 −1 1 1 −1 −1 |
| | −1 1 −1 −1 1 1 −1 −1 −1 1 1 1 −1 1 1 −1 −1 1 −1 1 −1 1 1 1 1 −1 −1 1 1 −1 −1 −1 |
| | −1 1 1 1 −1 −1 −1 −1 −1 1 1 −1 1 −1 1 1 1 −1 −1 1 −1 −1 −1 −1 1 −1 −1 1 −1 −1 |
| | −1 −1 1 −1 −1 −1 1 1 1 1 −1 −1 1 1 1 −1 1 1 −1 −1 1 −1 −1 −1 −1 1 −1 1 −1 1 1 1 |
| | 1 1 1 1 −1 −1 1 1 1 −1 −1 −1 −1 1 1 1 1 1 1 −1 1 1 1 −1 −1 −1 1 1 1 1 1 −1 −1 −1 |
| | 1 1 −1 1 1 −1 1 −1 1 −1 1 −1 −1 −1 1 −1 −1 1 1 1 −1 −1 −1 1 −1 1 1 1 1 −1 −1 −1 |
| | −1 1 −1 1 −1 1 1 −1 −1 −1 −1 −1 1 −1 −1 −1 1 1 −1 −1 −1 1 1 −1 −1 1 −1 −1 1 −1 |
| | −1 1 1 1 −1 1 −1 1 1 1 −1 −1 1 −1 1 −1 1 1 1 −1 1 1 −1 −1 1 −1 1 1 1 −1 1 −1 −1 |
| | −1 −1 1 −1 1 1 1 −1 −1 −1 −1 1 1 −1 −1 1 −1 −1 −1 −1 −1 1 1 1 1 −1 −1 −1 −1 −1 |
| | −1 −1 1 −1 −1 −1 −1 −1 −1 −1 −1 1 −1 −1 1 −1 −1 −1 −1 −1 −1 1 −1 −1 1 1 −1 −1 |
| | −1 −1 −1 −1 1 −1 −1 −1 1 −1 −1 −1 −1 1 1 1 1 1 1 1 −1 −1 −1 1 1 −1 −1 −1 1 −1 1 |
| | −1 −1 −1 1 −1 1 1 −1 −1 1 1 −1 1 −1 1 1 −1 −1 −1 −1 −1 1 1 −1 1 1 −1 −1 −1 1 1 |
| | 1 1 1 −1 1 1 −1 −1 1 −1 1 1 −1 −1 −1 −1 1 −1 −1 −1 −1 1 −1 −1 1 1 1 1 1 −1 1 −1 |
| | 1 −1 1 −1 1 −1 −1 1 1 −1 1 1 −1 −1 −1 −1 1 1 1 1 −1 −1 −1 −1 1 −1 1 1 1 −1 −1 1 |
| | −1 −1 1 1 −1 1 1 −1 −1 1 1 −1 −1 −1 −1 −1 1 1 −1 −1 −1 1 1 1 −1 1 −1 −1 1 1 1 1 |
| | −1 −1 1 1 −1 1 1 −1 −1 1 −1 1 1 1 1 1 1 −1 1 −1 1 1 1 1 −1 1 1 1 1 −1 1 1 1 1 −1 |
| | −1 1 −1 1 1 −1 1 1 1 1 1 −1 −1 −1 −1 −1 −1 1 1 −1 −1 −1 −1 1 1 −1 1 −1 1 −1 1 |
| | −1 −1 1 −1 1 1 −1 −1 1 1 1 −1 −1 −1 1 1 1 1 1 1 −1 1 1 −1 −1 1 −1 −1 1 1 −1 1 −1 |
| | 1 1 −1 −1 1 −1 1 1 −1 −1 1 −1 −1 −1 1 −1 −1 −1 −1 −1 −1 −1 −1 −1 −1 1 1 1 −1 |
| | −1 1 −1 −1 −1 1 1 −1 −1 1 −1 1 1 −1 −1 1 1 −1 1 1 1 −1 −1 1 −1 −1 1 1 1 1 −1 −1 |
| | 1 1 1 1 −1 −1 1 1 −1 −1 1 1 −1 −1 −1 1 −1 1 1 −1 −1 1 −1 1 −1 1 −1 −1 −1 1 1 −1 |
| | 1 1 1 −1 1 1 1 1 −1 −1 1 1 −1 −1 1 −1 −1 1 −1 −1 −1 1 −1 −1 −1 −1 1 −1 1 −1 1 |
| | −1 1 −1 1 −1 1 −1 1 1 1 −1 1 1 1 1 −1 1 −1 −1 1 1 −1 −1 1 −1 −1 1 −1 1 −1 −1 −1 |
| | 1 −1 −1 −1 −1 1 1 −1 1 −1 1 −1 −1 −1 1 1 1 1 1 1 −1 1 −1 −1 1 1 1 −1 1 −1 −1 1 1 |
| | −1 −1 1 1 −1 −1 −1 −1 −1 −1 1 1 −1 1 1 1 −1 −1 1 1 1 −1 −1 −1 −1 −1 1 −1 1 −1 1 |
| | −1 −1 1 1 1 1 1 −1 −1 −1 1 −1 1 −1 −1 1 −1 −1 −1 1 1 1 −1 −1 1 −1 −1 −1 −1 1 1 |
| | −1 −1 −1 1 −1 −1 −1 −1 −1 1 −1 −1 −1 −1 1 −1 −1 −1 1 −1 1 −1 −1 1 1 1 −1 −1 1 |
| | −1 1 1 −1 1 1 −1 1 −1 −1 1 −1 −1 1 −1 1 −1 1 1 1 1 −1 1 1 −1 −1 1 −1 −1 −1 1 1 1 |
| | 1 1 1 1 −1 1 1 −1 −1 1 1 −1 −1 1 1 1 −1 −1 1 −1 1 −1 1 −1 −1 1 −1 −1 1 −1 −1 1 1 |
| | −1 1 −1 1 −1 −1 1 1 1 1 1 1 −1 1 1 1 1 −1 1 1 −1 1 1 −1 −1 −1 1 −1 −1 1 −1 −1 −1 |
| | −1 1 1 −1 1 1 −1 1 1 1 −1 1 −1 −1 1 −1 −1 1 −1 −1 1 −1 −1 −1 −1 −1 −1 −1 −1 1 1 |
| | −1 −1 −1 1 −1 −1 1 −1 1 1 1 −1 −1 1 1 −1 1 1 −1 1 −1 1 −1 −1 −1 1 −1 −1 −1 −1 |
| | −1 1 1 1 1 1 −1 1 −1 1 −1 −1 −1 −1 −1 1 1 1 1 1 1 1 1 1 1 −1 −1 1 −1 1 −1 −1 −1 |
| | −1 −1 −1 1 −1 −1 −1 −1 1 1 1 1 −1 1 −1 −1 1 −1 1 −1 −1 −1 1 −1 1 −1 1 1 −1 −1 1 |
| | 1 1 −1 1 1 −1 −1 −1 −1 1 −1 1 1 −1 −1 −1 1 −1 −1 −1 −1 −1 −1 −1 1 −1 1 1 −1 1 |
| | −1 1 1 −1 1 1 −1 −1 1 1 1 1 −1 1 −1 −1 −1 1 1 1 −1 1 −1 1 −1 1 −1 1 1 1 −1 −1 1 |
| | −1 1 1 1 −1 1 1 1 1 1 −1 1 1 −1 −1 −1 1 −1 −1 1 1 −1 1 −1 −1 1 −1 −1 1 −1 −1 −1 |
| | −1 1 −1 1 −1 −1 1 −1 1 −1 1 1 1 −1 1 −1 −1 1 1 1 1 1 −1 −1 1 1 1 1 1 −1 1 1 −1 −1 |
| | −1 −1 −1 1 1 −1 −1 1 1 −1 1 1 1 −1 1 1 1 −1 −1 1 1 −1 −1 −1 −1 −1 −1 −1 1 1 1 |
| | −1 1 −1 1 1 1 −1 1 1 1 1 1 1 1 −1 −1 1 −1 1 1 −1 1 −1 1 −1 1 1 −1 −1 1 −1 −1 −1 |
| | −1 1 1 1 1 1 −1 1 1 −1 1 1 1 1 −1 −1 −1 1 −1 1 1 1 1 1 −1 1 −1 −1 −1 1 1 1 1 1 1 1 |
| | 1 1 −1 −1 1 1 1 1 −1 1 −1 −1 1 1 −1 1 1 1 −1 −1 −1 1 1 −1 −1 −1 1 1 1 1 −1 1 1 −1 |
| | −1 1 −1 1 −1 −1 1 −1 1 1 −1 1 −1 −1 −1 1 1 −1 −1 −1 1 −1 1 1 −1 1 1 1 1 1 1 −1 1 |
| | −1 1 −1 1 −1 −1 −1 1 1 −1 −1 1 −1 −1 −1 1 1 −1 −1 −1 −1 −1 1 1 −1 1 −1 −1 1 −1 |
| | −1 1 1 −1 1 −1 −1 −1 1 1 −1 1 1 −1 1 −1 −1 −1 −1 −1 1 −1 1 1 −1 1 −1 −1 1 1 1 |
| | −1 −1 −1 −1 1 1 −1 1 −1 1 1 1 1 −1 −1 −1 1 −1 −1 −1 −1 −1 −1 1 1 1 1 −1 −1 1 1 |
| | 1 1 1 −1 −1 1 1 −1 1 −1 −1 −1 1 −1 1 −1 −1 1 −1 −1 1 1 −1 1 1 −1 1 1 −1 −1 1 −1 |
| | −1 1 1 1 1 1 1 −1 −1 −1 −1 −1 1 −1 1 1 −1 1 1 −1 −1 1 −1 −1 −1 1 −1 1 −1 1 −1 1 |
| | −1 −1 1 −1 1 −1 −1 1 1 −1 1 −1 1 −1 1 −1 −1 −1 −1 −1 1 1 −1 1 −1 1 −1 1 1 −1 −1 |
| | −1 −1 1 −1 1 1 1 −1 1 1 1 −1 −1 1 −1 −1 1 −1 1 −1 −1 1 1 1 −1 1 −1 1 −1 −1 1 1 |
| | −1 1 1 1 −1 1 −1 −1 1 1 −1 −1 −1 1 1 −1 1 −1 −1 1 1 1 1 −1 −1 −1 1 1 1 −1 −1 −1 |
| | −1 −1 1 −1 −1 −1 −1 −1 1 1 1 −1 1 1 1 1 1 −1 1 −1 −1 1 −1 −1 −1 −1 −1 1 −1 −1 1 |
| | 1 −1 1 1 1 1 1 −1 −1 1 1 1 1 −1 −1 −1 1 1 −1 −1 1 −1 1 −1 1 1 −1 −1 1 1 −1 −1 −1 |
| | 1 1 −1 −1 1 1 −1 −1 −1 1 1 1 −1 −1 1 1 −1 −1 −1 1 1 1 1 −1 −1 1 1 −1 −1 −1 1 1 |
| | −1 1 1 −1 −1 1 −1 1 −1 1 −1 1 −1 −1 1 1 1 1 −1 −1 1 −1 −1 −1 1 1 −1 1 1 1 1 −1 |
| | −1 −1 −1 1 −1 −1 −1 −1 1 1 −1 −1 1 −1 1 1 1 1 −1 −1 1 −1 1 −1 1 −1 −1 −1 −1 1 1 |
| | 1 −1 1 −1 −1 1 1 −1 1 1 −1 −1 1 −1 −1 1 −1 1 −1 1 −1 −1 −1 1 −1 −1 −1 1 −1 −1 1 |
| | −1 1 1 1 1 −1 −1 1 1 1 1 1 −1 −1 1 1 1 −1 1 −1 1 1 −1 1 1 −1 1 −1 −1 −1 −1 1 1 |
| | 1 1 −1 −1 1 1 −1 1 −1 −1 1 1 1 1 1 −1 1 1 −1 1 −1 1 −1 −1 1 −1 1 1 1 1 −1 −1 −1 1 |
| | −1 1 −1 1 −1 1 1 1 −1 1 −1 1 −1 −1 −1 −1 −1 −1 1 −1 1 −1 1 1 −1 1 1 1 1 −1 1 −1 |
| | 1 −1 1 1 −1 −1 1 1 −1 1 −1 −1 1 1 −1 1 −1 −1 −1 1 −1 −1 −1 1 1 1 −1 1 −1 −1 1 |
| | −1 1 −1 −1 1 1 1 1 1 1 1 1 −1 1 −1 −1 1 −1 −1 1 −1 1 1 1 −1 1 −1 −1 1 −1 −1 −1 |
| | −1 1 1 1 −1 −1 1 −1 −1 1 1 −1 −1 1 1 −1 −1 1 −1 1 −1 −1 1 −1 −1 1 1 1 1 −1 −1 |
| | −1 1 −1 1 1 −1 1 −1 −1 −1 −1 −1 1 1 1 −1 −1 −1 −1 −1 −1 1 1 1 1 1 1 −1 −1 −1 −1 |
| | 1 1 1 1 −1 −1 1 −1 −1 −1 −1 1 1 1 −1 1 1 1 −1 −1 1 −1 1 1 1 1 1 −1 1 −1 1 −1 −1 1 |
| | −1 1 1 −1 1 1 −1 1 1 −1 −1 −1 1 1 −1 −1 −1 1 −1 −1 −1 1 −1 −1 −1 1 −1 −1 −1 −1 |
| | −1 1 −1 1 −1 1 1 1 −1 −1 −1 −1 1 1 1 −1 −1 −1 1 −1 −1 1 1 1 −1 −1 1 1 1 1 −1 1 1 |
| | 1 −1 −1 1 −1 1 −1 1 −1 1 1 1 −1 −1 −1 −1 −1 1 −1 −1 1 −1 1 1 −1 1 −1 −1 1 1 −1 |
| | −1 1 −1 1 1 1 1 1 −1 −1 −1 −1 −1 1 1 −1 −1 1 −1 −1 −1 1 −1 −1 1 −1 1 −1 1 −1 −1 |
| | 1 1 1 −1 1 1 −1 1 1 −1 −1 −1 −1 −1 1 1 1 −1 −1 1 1 1 1 −1 −1 1 −1 −1 1 1 −1 −1 |
| | −1 1 1 −1 −1 −1 1 1 −1 1 1 1 −1 −1 −1 −1 −1 1 1 1 −1 1 −1 −1 −1 −1 1 −1 −1 1 −1 |
| | −1 1 −1 −1 −1 1 −1 1 −1 1 1 1 1 −1 −1 −1 1 1 −1 1 −1 1 −1 1 −1 1 1 1 1 −1 −1 −1 |
| | −1 1 1 1 1 1 −1 −1 −1 1 −1 −1 −1 1 1 1 −1 −1 −1 1 1 1 1 −1 1 1 1 −1 −1 −1 −1 −1 |
| | −1 −1 −1 1 −1 1 −1 1 1 1 1 −1 1 −1 −1 1 1 1 −1 −1 −1 1 1 −1 −1 −1 −1 1 −1 1 1 1 |
| | 1 1 −1 1 1 −1 1 1 −1 1 1 −1 1 1 −1 −1 1 1 −1 −1 1 −1 1 1 −1 −1 −1 1 1 1 −1 1 −1 1 |
| | 1 −1 1 −1 −1 −1 −1 1 −1 −1 −1 1 1 −1 1 1 −1 −1 1 1 1 1 1 1 1 −1 1 1 1 −1 −1 1 1 |
| | −1 1 −1 1 −1 1 −1 1 −1 1 −1 −1 1 −1 −1 −1 1 1 −1 −1 1 1 1 −1 −1 1 1 1 1 1 1 −1 1 |
| | 1 −1 1 1 1 −1 −1 1 −1 −1 −1 1 −1 1 1 −1 1 −1 1 1 1 1 −1 −1 1 1 1 −1 1 −1 −1 1 1 1 |
| | −1 −1 1 1 −1 −1 1 −1 −1 −1 −1 1 −1 −1 −1 −1 1 −1 1 1 −1 1 −1 1 −1 −1 −1 1 1 −1 |
| | 1 −1 1 1 1 −1 1 1 1 −1 1 −1 1 1 −1 1 1 1 1 1 −1 1 −1 1 −1 1 1 1 1 −1 −1 1 −1 −1 1 |
| | −1 1 1 1 −1 −1 −1 1 1 1 −1 −1 1 1 1 −1 1 1 −1 1 1 1 −1 1 −1 1 1 1 −1 −1 −1 −1 −1 |
| | −1 −1 1 1 1 1 1 1 1 −1 1 −1 −1 1 1 −1 −1 −1 −1 1 1 1 1 −1 1 −1 1 1 1 1 1 −1 −1 −1 |
| | −1 1 1 −1 −1 1 1 −1 1 −1 1 1 1 −1 1 −1 1 1 1 1 1 1 1 1 1 −1 −1 −1 1 −1 1 1 1 −1 1 |
| | 1 1 1 −1 −1 −1 1 1 −1 −1 −1 −1 −1 −1 −1 1 −1 1 1 1 1 1 1 −1 −1 1 −1 −1 −1 −1 −1 |
| | −1 −1 1 −1 −1 1 1 1 1 1 1 1 1 1 1 −1 −1 −1 −1 −1 −1 1 −1 −1 1 −1 1 1 1 1 1 −1 |
| | −1 1 −1 1 1 −1 −1 −1 −1 −1 −1 1 −1 1 1 −1 1 1 1 −1 −1 −1 1 −1 1 1 1 −1 −1 1 −1 |
| | 1 1 −1 −1 −1 1 1 1 1 1 1 1 1 −1 1 1 1 −1 1 1 −1 −1 −1 −1 1 1 1 −1 −1 1 −1 1 |
| | 1 −1 −1 1 1 1 1 −1 1 1 −1 1 1 −1 1 −1 −1 −1 1 1 −1 1 −1 −1 −1 −1 1 −1 −1 1 1 −1 |
| | −1 −1 1 −1 1 1 1 −1 −1 −1 −1 −1 1 1 −1 −1 −1 −1 1 −1 −1 −1 −1 −1 −1 1 1 −1 1 1 |
| | −1 −1 1 1 −1 1 −1 1 −1 −1 1 −1 1 −1 1 −1 −1 1 −1 1 1 1 −1 −1 1 −1 −1 −1 1 1 1 |
| | −1 −1 −1 −1 1 −1 1 1 1 1 −1 −1 −1 1 1 1 1 1 1 1 1 −1 −1 1 1 −1 1 1 1 1 −1 1 −1 −1 |
| | 1 −1 −1 1 1 1 −1 1 1 1 −1 1 1 −1 1 1 1 −1 −1 −1 −1 1 −1 −1 −1 1 −1 −1 1 1 −1 −1 |
| | −1 −1 1 −1 −1 −1 1 −1 1 1 −1 −1 1 −1 −1 −1 −1 −1 1 −1 1 −1 −1 1 −1 −1 1 −1 −1 |
| | −1 1 1 1 1 1 −1 1 1 1 −1 −1 −1 −1 1 −1 1 −1 −1 −1 1 1 1 1 −1 −1 1 −1 1 1 1 −1 −1 |
| | −1 −1 −1 −1 1 1 −1 1 −1 1 1 −1 −1 1 1 1 −1 −1 1 1 −1 1 −1 1 1 1 1 1 1 1 −1 1 1 −1 |
| | 1 1 −1 −1 1 1 1 −1 −1 −1 −1 1 −1 1 −1 1 −1 −1 1 −1 1 −1 1 1 −1 −1 −1 −1 1 1 1 |
| | −1 1 1 1 1 −1 −1 −1 −1 1 1 −1 1 −1 −1 1 −1 1 1 −1 −1 −1 −1 −1 1 1 1 1 −1 −1 1 |
| | −1 1 −1 1 1 −1 1 −1 −1 1 1 1 1 −1 1 −1 −1 1 −1 −1 −1 1 −1 −1 −1 1 1 1 1 1 1 −1 |
| | −1 −1 1 1 −1 1 −1 −1 −1 −1 −1 −1 1 1 −1 −1 −1 1 1 −1 −1 −1 −1 1 1 1 −1 1 −1 1 |
| | −1 −1 1 −1 −1 −1 1 −1 −1 1 1 −1 1 −1 1 1 1 −1 −1 −1 −1 1 −1 1 1 −1 1 1 −1 1 1 1 |
| | −1 1 1 −1 −1 −1 1 1 −1 1 1 −1 1 1 1 1 1 1 −1 −1 −1 −1 −1 −1 −1 −1 1 1 1 1 1 −1 1 |
| | 1 1 1 −1 1 −1 −1 −1 1 1 −1 −1 −1 −1 −1 −1 1 1 1 1 −1 1 1 −1 1 −1 1 −1 1 1 1 1 −1 |
| | 1 1 1 −1 −1 −1 1 −1 1 −1 1 1 −1 −1 −1 1 −1 −1 −1 1 −1 1 −1 −1 −1 1 −1 −1 1 1 −1 |
| | −1 1 −1 −1 −1 1 −1 1 1 1 1 1 1 −1 1 1 1 −1 1 −1 −1 1 −1 1 1 1 −1 −1 −1 −1 1 −1 |
| | −1 1 1 1 −1 −1 1 −1 1 −1 −1 −1 1 1 1 −1 1 1 −1 1 −1 1 −1 1 −1 1 −1 −1 −1 1 1 1 |
| | −1 −1 −1 1 −1 1 −1 −1 −1 1 1 1 −1 −1 1 1 1 1 1 −1 −1 −1 1 1 1 1 −1 −1 −1 −1 1 1 |
| | 1 −1 1 1 −1 1 1 −1 1 −1 1 −1 −1 1 1 1 −1 1 −1 −1 −1 1 1 −1 −1 1 −1 1 −1 −1 1 1 |
| | −1 −1 1 −1 1 −1 1 −1 1 1 −1 −1 1 −1 1 −1 1 1 −1 1 1 −1 −1 1 −1 1 −1 −1 −1 −1 −1 |
| | 1 1 1 −1 1 −1 1 −1 1 1 1 −1 1 1 −1 1 1 1 1 −1 1 −1 −1 −1 −1 1 1 −1 1 −1 −1 1 1 1 |
| | −1 −1 1 −1 −1 1 1 1 −1 −1 1 1 −1 1 1 1 −1 1 −1 1 1 −1 −1 1 −1 1 −1 −1 1 1 1 −1 |
| | −1 −1 −1 −1 1 1 1 1 1 1 −1 1 −1 1 1 −1 1 1 1 −1 1 1 1 1 1 −1 −1 1 1 −1 1 1 −1 1 1 |
| | 1 1 −1 1 1 −1 1 −1 −1 1 −1 −1 −1 −1 −1 −1 −1 1 1 −1 −1 1 −1 1 1 −1 1 1 −1 −1 −1 |
| | 1 1 1 −1 1 1 1 −1 −1 −1 −1 −1 1 −1 1 1 1 1 −1 −1 1 1 −1 1 −1 1 1 −1 1 −1 1 −1 −1 |
| | 1 −1 −1 1 −1 1 1 −1 −1 −1 −1 1 1 −1 1 −1 −1 −1 −1 −1 1 1 −1 −1 1 −1 1 −1 −1 −1 |
| | 1 1 −1 −1 −1 1 1 1 −1 −1 −1 1 1 −1 1 1 1 −1 1 −1 1 −1 −1 1 1 1 1 −1 1 1 1 −1 1 1 |
| | 1 1 1 1 −1 −1 1 1 1 1 1 1 1 −1 −1 1 −1 −1 1 1 1 1 1 −1 −1 1 −1 1 −1 1 1 1 1 1 −1 |
| | −1 1 1 −1 −1 1 1 1 −1 1 1 1 1 1 1 −1 1 1 −1 1 −1 1 1 −1 −1 −1 −1 1 1 −1 −1 −1 1 |
| | −1 1 −1 1 −1 −1 −1 −1 1 −1 1 1 1 1 −1 1 −1 −1 1 −1 1 1 −1 1 1 1 1 −1 −1 1 −1 1 |
| | −1 −1 −1 1 −1 1 1 1 −1 −1 1 1 1 −1 −1 1 −1 1 1 1 1 −1 −1 −1 −1 −1 −1 −1 −1 −1 1 |
| | −1 1 −1 −1 1 −1 1 1 1 −1 1 1 1 −1 1 1 1 −1 −1 −1 1 1 −1 1 −1 −1 1 −1 1 −1 −1 1 |
| | −1 1 −1 1 −1 1 1 1 1 −1 1 −1 1 1 −1 1 1 −1 −1 −1 1 −1 1 1 1 −1 1 −1 1 −1 −1 1 −1 |
| | 1 −1 −1 −1 1 1 1 1 1 −1 −1 −1 −1 1 1 1 −1 −1 1 1 1 −1 −1 1 1 1 −1 1 −1 −1 −1 1 |
| | −1 −1 1 1 1 1 −1 1 1 1 1 1 −1 1 −1 1 1 1 −1 1 −1 −1 −1 −1 −1 −1 −1 1 −1 −1 −1 1 |
| | −1 1 −1 1 1 −1 1 1 −1 1 1 1 1 1 −1 −1 1 −1 1 −1 −1 1 −1 1 −1 −1 −1 −1 1 −1 1 −1 |
| | −1 −1 1 −1 1 −1 −1 1 1 −1 −1 1 1 1 1 1 1 1 1 1 −1 1 1 −1 1 −1 −1 1 1 −1 1 −1 1 −1 |
| | −1 −1 1 −1 1 −1 1 −1 −1 1 1 −1 1 −1 −1 1 −1 1 1 1 −1 1 −1 1 1 1 −1 1 −1 1 −1 1 |
| | −1 1 −1 1 1 −1 −1 −1 1 −1 1 −1 −1 −1 −1 −1 −1 1 1 −1 1 −1 −1 1 1 −1 1 1 1 −1 |
| | 1 −1 1 −1 1 −1 −1 1 −1 −1 1 1 −1 −1 1 1 1 |
| 9 | −1 −1 −1 −1 −1 −1 −1 −1 −1 −1 −1 −1 −1 1 −1 −1 −1 1 −1 1 −1 1 1 1 1 −1 1 −1 |
| | −1 −1 1 1 1 −1 −1 1 1 −1 −1 1 −1 −1 1 1 1 1 −1 −1 −1 1 1 −1 1 1 −1 −1 1 1 −1 −1 |
| | 1 1 −1 1 1 1 1 1 −1 −1 −1 1 1 −1 1 1 1 1 1 1 1 1 −1 −1 1 1 1 1 −1 −1 1 −1 −1 −1 1 |
| | −1 −1 1 −1 1 −1 1 −1 −1 −1 1 1 1 1 −1 −1 −1 −1 −1 1 1 1 1 −1 −1 −1 −1 −1 −1 −1 |
| | 1 1 1 1 1 1 1 −1 −1 1 −1 −1 −1 1 1 −1 −1 −1 −1 −1 1 −1 −1 1 1 1 −1 1 −1 1 −1 1 1 |
| | 1 −1 −1 −1 1 1 1 1 −1 1 1 −1 1 1 −1 −1 1 −1 1 1 1 1 1 1 −1 −1 1 1 1 1 1 1 1 −1 1 1 |
| | −1 1 1 1 −1 1 1 −1 1 −1 −1 −1 1 1 −1 −1 1 −1 1 −1 −1 −1 1 −1 −1 −1 −1 1 −1 −1 1 |
| | 1 −1 −1 1 −1 1 1 1 −1 1 −1 1 −1 −1 −1 1 −1 1 1 −1 −1 −1 1 −1 1 −1 1 −1 |
| | 1 −1 1 1 −1 −1 1 −1 1 −1 1 1 1 1 −1 1 1 1 −1 1 −1 −1 1 1 −1 1 −1 −1 −1 1 1 1 1 −1 |
| | 1 −1 1 −1 −1 1 1 1 −1 1 −1 −1 1 −1 −1 −1 1 −1 −1 1 −1 −1 1 1 −1 1 1 −1 −1 −1 1 |
| | −1 −1 1 1 1 1 1 −1 1 −1 1 −1 1 −1 1 −1 −1 −1 1 −1 1 1 1 1 −1 1 1 −1 1 −1 1 1 −1 1 |
| | −1 1 1 1 −1 −1 −1 1 −1 1 −1 −1 −1 1 −1 1 1 1 −1 1 1 1 1 −1 1 −1 −1 −1 1 −1 −1 |
| | −1 −1 −1 −1 1 1 −1 −1 −1 1 −1 −1 −1 −1 −1 1 1 1 1 1 −1 −1 1 1 −1 1 −1 −1 1 −1 1 |
| | −1 1 1 −1 −1 1 1 1 −1 −1 −1 1 −1 1 −1 1 −1 −1 −1 −1 1 1 −1 1 −1 1 1 1 1 −1 1 −1 |
| | −1 1 −1 1 1 1 1 −1 −1 1 −1 1 −1 1 −1 −1 1 1 1 −1 −1 −1 1 1 1 −1 −1 1 −1 1 1 −1 1 |
| | 1 1 1 1 −1 1 −1 1 −1 1 1 −1 −1 −1 1 −1 1 −1 −1 1 1 −1 −1 −1 1 1 −1 −1 1 −1 −1 |
| | −1 −1 1 −1 −1 1 1 1 1 1 −1 −1 1 1 −1 −1 1 −1 1 1 −1 1 −1 −1 −1 −1 1 −1 −1 1 −1 |
| | −1 −1 −1 1 1 1 1 −1 1 −1 −1 −1 −1 −1 −1 1 1 −1 1 −1 −1 −1 1 −1 −1 −1 1 −1 1 1 |
| | −1 −1 −1 −1 1 1 −1 −1 1 −1 1 −1 1 −1 −1 −1 1 −1 −1 1 −1 1 1 1 1 −1 1 1 1 1 1 1 |
| | −1 −1 1 −1 1 −1 1 −1 1 −1 1 1 1 1 1 −1 −1 1 −1 −1 −1 1 −1 1 −1 −1 1 1 −1 1 1 1 1 |
| | 1 1 −1 1 1 −1 −1 1 1 1 −1 1 1 −1 1 −1 1 1 −1 −1 1 1 1 −1 1 1 1 −1 −1 1 −1 1 1 −1 |
| | −1 1 −1 1 −1 −1 1 −1 1 1 1 1 1 −1 −1 −1 −1 −1 1 −1 −1 −1 1 1 1 −1 −1 −1 1 −1 1 |
| | −1 −1 1 −1 −1 1 −1 −1 1 −1 −1 1 1 −1 −1 1 1 −1 1 1 −1 −1 1 −1 1 1 −1 −1 1 1 1 1 |
| | −1 −1 −1 1 1 1 −1 1 −1 1 −1 −1 1 1 1 1 −1 −1 −1 −1 1 1 1 −1 −1 −1 1 1 1 −1 1 −1 |
| | −1 1 −1 1 −1 −1 −1 1 1 −1 −1 1 −1 −1 1 −1 −1 −1 1 1 1 1 1 −1 −1 −1 −1 1 −1 1 1 |
| | 1 −1 1 1 −1 1 1 1 1 −1 −1 1 −1 1 −1 −1 1 −1 1 −1 −1 1 1 1 1 1 1 1 1 −1 −1 1 −1 −1 |
| | 1 −1 1 −1 1 1 1 1 −1 −1 −1 1 −1 −1 1 1 −1 −1 −1 1 −1 1 1 −1 1 1 −1 −1 1 1 1 1 −1 |
| | −1 1 −1 1 1 1 −1 1 −1 1 −1 1 1 −1 −1 1 −1 −1 1 1 1 −1 −1 1 −1 −1 1 −1 1 1 1 −1 1 |
| | −1 −1 −1 −1 1 1 −1 1 −1 −1 −1 1 1 1 −1 1 1 −1 −1 1 1 −1 −1 1 −1 1 1 1 −1 −1 −1 |
| | 1 1 −1 1 1 1 −1 −1 1 1 −1 1 1 −1 −1 1 −1 1 −1 1 −1 −1 −1 −1 −1 −1 −1 −1 −1 −1 |
| | −1 1 1 1 −1 1 1 −1 1 −1 −1 1 1 −1 −1 1 1 −1 1 −1 1 −1 1 1 −1 −1 1 1 1 1 1 −1 1 1 |
| | −1 1 −1 1 −1 −1 −1 −1 −1 1 1 −1 −1 1 1 −1 −1 −1 −1 1 1 1 −1 1 −1 1 −1 −1 −1 −1 |
| | 1 1 1 1 1 1 −1 1 1 −1 1 1 −1 1 1 1 1 −1 1 1 1 1 1 −1 1 −1 1 1 −1 1 −1 1 1 −1 1 −1 |
| | −1 −1 1 −1 1 1 −1 1 −1 −1 −1 −1 −1 1 −1 1 1 1 1 1 −1 1 1 1 1 −1 1 −1 −1 1 −1 −1 |
| | −1 1 1 1 1 −1 1 −1 −1 1 −1 1 −1 −1 1 −1 1 −1 1 −1 1 1 −1 −1 −1 −1 −1 −1 −1 1 1 |
| | 1 −1 −1 1 1 1 1 −1 1 1 −1 1 1 1 1 1 −1 −1 −1 −1 −1 −1 1 −1 −1 −1 −1 −1 1 1 −1 1 |
| | −1 −1 1 1 1 −1 1 1 −1 1 1 1 −1 −1 1 1 1 1 −1 −1 1 1 1 −1 1 1 1 −1 1 −1 −1 1 −1 1 |
| | 1 −1 1 1 −1 −1 −1 1 −1 1 1 −1 1 −1 1 −1 1 −1 −1 −1 1 1 1 −1 1 −1 −1 1 1 −1 −1 |
| | −1 1 −1 −1 1 1 1 −1 −1 −1 1 1 −1 1 −1 1 1 −1 −1 1 −1 1 1 1 −1 1 −1 −1 1 1 1 1 1 |
| | −1 1 1 1 1 1 1 1 −1 −1 −1 −1 −1 1 −1 1 1 1 1 −1 1 1 1 −1 −1 1 −1 1 −1 1 −1 1 1 −1 |
| | 1 1 −1 −1 1 1 −1 −1 −1 −1 −1 1 −1 −1 −1 −1 1 −1 −1 1 −1 1 −1 1 1 −1 1 1 −1 1 1 |
| | −1 −1 1 −1 −1 −1 1 1 −1 −1 1 1 −1 1 1 1 −1 −1 −1 −1 1 −1 −1 1 −1 1 1 1 −1 −1 −1 |
| | 1 −1 1 1 1 −1 1 1 −1 −1 −1 1 1 1 1 −1 1 −1 −1 −1 1 1 −1 1 −1 1 −1 1 1 −1 1 −1 1 1 |
| | −1 −1 1 −1 −1 −1 1 −1 −1 1 1 −1 −1 1 1 1 1 −1 −1 1 1 −1 1 1 1 −1 1 −1 1 1 1 −1 1 |
| | −1 1 −1 1 −1 1 −1 1 1 1 −1 −1 −1 −1 −1 1 1 1 −1 −1 1 −1 1 −1 −1 −1 1 −1 1 1 −1 |
| | 1 1 1 −1 −1 1 −1 1 −1 −1 1 1 1 1 −1 −1 1 1 1 1 −1 1 1 1 −1 1 1 −1 −1 1 1 1 −1 −1 |
| | −1 −1 1 1 −1 −1 1 1 1 1 1 1 −1 −1 1 −1 1 1 −1 −1 1 1 −1 −1 −1 −1 1 −1 −1 −1 1 1 |
| | −1 1 1 1 −1 1 1 −1 −1 −1 1 −1 −1 1 −1 −1 1 1 1 −1 1 −1 1 1 −1 1 1 1 1 1 −1 −1 1 1 |
| | −1 −1 −1 1 1 1 1 −1 1 1 1 −1 1 −1 1 −1 1 −1 −1 1 1 1 −1 1 1 1 1 −1 1 1 −1 1 1 1 |
| | −1 −1 −1 −1 1 1 1 1 −1 −1 −1 −1 1 1 −1 1 −1 −1 −1 −1 −1 1 −1 −1 −1 1 1 −1 1 −1 |
| | −1 −1 1 −1 1 1 1 −1 −1 −1 1 1 1 −1 1 1 1 1 −1 −1 1 1 1 −1 1 −1 −1 −1 1 1 1 −1 1 |
| | −1 1 −1 1 −1 1 1 −1 1 1 1 1 1 1 1 1 1 1 1 1 −1 −1 1 1 −1 −1 −1 −1 −1 1 1 1 −1 −1 |
| | −1 1 1 −1 1 1 −1 1 −1 1 −1 1 −1 −1 1 −1 1 1 1 −1 1 1 −1 1 −1 −1 1 −1 1 −1 1 −1 1 |
| | −1 1 −1 −1 1 1 1 1 −1 1 1 −1 1 −1 −1 1 1 1 1 1 1 1 −1 1 −1 1 1 1 −1 1 −1 −1 1 1 |
| | −1 −1 1 −1 −1 −1 −1 −1 −1 1 1 −1 1 1 1 1 −1 1 1 1 1 −1 1 1 1 −1 1 1 1 1 1 1 −1 1 1 |
| | 1 1 1 1 −1 1 −1 −1 1 1 −1 1 −1 1 1 1 1 −1 −1 1 −1 1 1 −1 −1 −1 −1 −1 −1 1 1 −1 1 |
| | 1 −1 1 1 1 −1 −1 1 −1 −1 1 −1 1 −1 −1 −1 1 1 1 1 1 −1 1 −1 1 1 1 1 1 1 −1 −1 1 −1 |
| | −1 1 1 −1 −1 1 −1 −1 −1 1 1 −1 1 −1 1 −1 −1 −1 −1 1 1 −1 −1 1 1 1 −1 −1 1 −1 1 |
| | −1 1 −1 −1 −1 −1 1 −1 1 1 −1 −1 −1 −1 −1 1 1 −1 −1 −1 1 −1 1 1 −1 −1 −1 −1 −1 |
| | −1 −1 −1 −1 1 −1 1 −1 −1 −1 −1 −1 1 1 1 −1 −1 1 1 −1 −1 −1 1 −1 1 −1 −1 −1 1 1 |
| | −1 1 1 1 −1 −1 −1 −1 −1 1 −1 1 1 −1 −1 −1 1 −1 −1 1 1 −1 −1 1 −1 −1 1 −1 1 −1 |
| | −1 1 −1 1 1 −1 −1 1 −1 1 1 1 1 −1 −1 −1 −1 −1 −1 −1 −1 −1 1 1 −1 −1 −1 1 1 1 −1 |
| | −1 1 −1 −1 −1 −1 1 −1 −1 −1 −1 1 1 −1 1 1 −1 −1 −1 −1 1 1 −1 −1 −1 1 1 −1 −1 1 |
| | 1 1 −1 −1 −1 1 1 −1 −1 1 1 1 1 1 −1 1 −1 1 1 −1 −1 1 1 1 1 −1 1 1 1 1 −1 1 −1 1 |
| | −1 −1 −1 1 −1 −1 −1 −1 −1 1 −1 1 −1 1 1 −1 1 1 −1 −1 −1 −1 −1 −1 1 1 1 −1 1 −1 |
| | −1 −1 −1 1 1 1 −1 −1 −1 1 −1 −1 −1 1 1 1 −1 1 −1 −1 −1 −1 −1 −1 1 −1 1 1 −1 1 1 |
| | −1 1 1 −1 1 −1 −1 −1 1 −1 −1 1 1 1 1 −1 −1 −1 −1 −1 −1 1 −1 1 1 −1 −1 −1 −1 1 |
| | −1 1 −1 1 1 −1 1 −1 1 −1 −1 1 1 1 −1 −1 1 −1 1 1 1 1 −1 1 −1 1 −1 1 −1 −1 −1 1 |
| | −1 −1 −1 1 1 1 −1 −1 1 −1 −1 1 1 1 −1 1 1 1 −1 −1 −1 1 1 1 1 1 −1 1 −1 −1 −1 1 1 |
| | −1 −1 1 1 −1 −1 −1 1 −1 1 1 1 −1 1 −1 1 −1 −1 −1 −1 −1 −1 1 1 −1 −1 1 −1 −1 −1 |
| | 1 1 1 −1 −1 1 1 1 1 1 −1 1 −1 −1 −1 −1 −1 −1 −1 −1 −1 1 1 1 1 −1 1 −1 −1 1 1 −1 |
| | −1 −1 −1 1 −1 1 −1 −1 1 1 1 1 1 −1 −1 1 −1 1 −1 1 1 −1 −1 1 −1 −1 −1 −1 1 −1 1 |
| | −1 1 1 −1 −1 1 1 −1 1 −1 −1 −1 1 −1 1 −1 −1 −1 −1 1 −1 −1 −1 1 1 1 1 −1 1 1 1 1 |
| | −1 −1 1 1 −1 1 1 −1 1 1 −1 −1 −1 −1 1 −1 −1 1 −1 −1 1 −1 −1 1 −1 1 −1 1 −1 1 −1 |
| | −1 1 −1 1 −1 −1 −1 1 −1 1 −1 1 1 1 −1 1 1 −1 1 1 −1 −1 −1 −1 −1 1 −1 1 −1 1 1 1 −1 1 |
| | 1 1 −1 1 1 −1 1 1 −1 1 1 −1 −1 −1 1 −1 −1 −1 −1 1 1 −1 1 −1 1 −1 −1 1 −1 −1 1 1 |
| | −1 1 1 1 1 −1 1 1 1 −1 −1 −1 1 1 −1 −1 1 −1 −1 1 1 1 −1 1 −1 −1 −1 −1 1 −1 −1 |
| | −1 −1 1 −1 1 1 1 1 1 1 1 −1 1 −1 −1 1 −1 −1 −1 −1 −1 1 1 1 −1 1 1 −1 −1 1 −1 1 |
| | −1 1 1 −1 −1 −1 1 −1 −1 1 −1 1 −1 1 1 1 −1 1 −1 −1 −1 1 1 −1 −1 −1 −1 −1 −1 1 |
| | −1 1 −1 −1 1 −1 1 1 −1 1 −1 −1 1 −1 −1 −1 1 1 −1 −1 −1 1 1 1 −1 1 −1 −1 −1 1 1 |
| | −1 1 1 −1 −1 1 −1 1 −1 1 −1 1 −1 −1 −1 1 1 −1 1 1 −1 1 −1 −1 1 1 −1 1 −1 1 −1 |
| | −1 1 −1 1 −1 1 −1 −1 −1 −1 −1 1 1 1 1 1 1 1 1 1 1 −1 1 1 −1 −1 1 −1 −1 −1 1 −1 1 |
| | −1 1 −1 1 −1 −1 −1 −1 −1 −1 1 −1 1 −1 1 1 1 1 −1 −1 1 −1 −1 −1 −1 −1 1 1 1 1 −1 |
| | 1 −1 1 −1 1 −1 1 1 1 −1 1 1 −1 −1 −1 −1 −1 1 1 1 −1 1 1 1 1 1 −1 −1 1 −1 −1 1 −1 |
| | −1 1 1 1 −1 −1 1 1 1 1 −1 −1 −1 −1 1 −1 −1 −1 −1 1 −1 −1 −1 1 1 −1 −1 −1 1 −1 |
| | −1 −1 1 1 1 1 −1 −1 −1 1 1 1 1 −1 −1 1 1 1 −1 −1 −1 1 −1 −1 1 1 −1 1 1 1 −1 −1 |
| | −1 1 −1 −1 −1 −1 1 −1 −1 −1 −1 −1 −1 −1 1 −1 1 1 1 1 1 1 −1 1 1 −1 1 −1 1 1 1 |
| | −1 −1 1 −1 −1 1 1 1 1 −1 1 1 1 1 1 −1 −1 1 1 1 1 −1 1 −1 −1 −1 1 −1 1 1 −1 −1 1 |
| | −1 −1 1 1 −1 1 −1 1 1 1 −1 1 −1 1 1 −1 −1 1 1 −1 −1 −1 1 −1 −1 −1 1 −1 −1 1 −1 |
| | 1 1 −1 −1 −1 1 −1 −1 −1 −1 −1 −1 −1 1 1 −1 1 1 −1 −1 −1 1 −1 1 −1 1 1 −1 −1 1 |
| | −1 1 1 −1 1 1 −1 1 −1 −1 −1 −1 1 −1 1 −1 −1 −1 1 1 −1 −1 −1 1 −1 1 1 1 1 −1 −1 |
| | 1 1 1 1 1 1 −1 1 1 1 1 −1 −1 −1 1 1 1 −1 −1 1 1 −1 1 −1 −1 −1 −1 −1 −1 −1 1 −1 |
| | −1 1 −1 1 −1 1 −1 1 1 1 1 −1 −1 1 1 1 −1 −1 1 −1 −1 −1 −1 −1 1 −1 −1 1 −1 −1 1 |
| | −1 1 −1 −1 1 1 −1 1 −1 1 −1 1 −1 −1 1 1 −1 1 1 1 −1 −1 1 −1 −1 −1 1 1 −1 1 1 −1 |
| | −1 −1 1 1 −1 −1 1 −1 1 1 −1 1 1 1 −1 −1 −1 1 1 −1 1 −1 −1 −1 −1 −1 −1 1 −1 −1 |
| | −1 −1 1 −1 1 −1 −1 1 1 −1 −1 1 −1 1 −1 1 −1 1 1 1 −1 1 −1 1 −1 −1 1 1 −1 −1 −1 |
| | −1 1 1 −1 −1 −1 −1 −1 −1 −1 −1 −1 −1 1 1 −1 1 1 1 1 −1 1 1 −1 1 −1 −1 −1 −1 1 1 |
| | −1 −1 −1 1 −1 −1 1 1 −1 1 −1 −1 −1 −1 1 −1 1 1 1 −1 1 −1 1 1 1 −1 −1 1 1 −1 −1 |
| | 1 −1 1 −1 1 1 −1 1 1 1 −1 1 −1 1 −1 1 1 1 1 1 −1 1 −1 −1 −1 1 −1 1 −1 1 −1 1 1 1 |
| | −1 −1 1 1 −1 1 −1 −1 1 1 −1 −1 1 −1 1 1 −1 −1 1 −1 −1 1 −1 1 1 −1 −1 −1 −1 1 −1 |
| | −1 1 1 1 1 −1 1 −1 1 −1 1 1 −1 1 1 1 −1 −1 1 1 −1 −1 −1 −1 −1 −1 −1 1 −1 1 1 −1 |
| | −1 1 1 1 −1 −1 1 −1 −1 1 1 −1 1 1 1 −1 1 1 1 −1 1 1 1 −1 1 −1 −1 −1 1 1 1 1 −1 −1 |
| | 1 1 −1 1 −1 −1 −1 1 1 −1 −1 −1 1 1 −1 1 1 −1 1 1 −1 −1 1 1 1 −1 1 −1 1 1 −1 −1 |
| | −1 1 1 −1 1 1 −1 −1 −1 −1 −1 −1 −1 −1 1 −1 −1 1 1 1 1 1 1 1 1 1 1 1 −1 1 −1 1 −1 |
| | 1 1 1 1 −1 1 1 −1 1 1 −1 1 −1 −1 1 −1 −1 −1 −1 −1 −1 −1 1 −1 −1 −1 1 1 −1 −1 1 |
| | −1 −1 −1 1 −1 −1 −1 −1 −1 −1 −1 −1 −1 −1 1 −1 1 1 1 −1 −1 1 −1 −1 −1 1 −1 1 1 |
| | 1 1 1 1 −1 −1 −1 −1 1 1 −1 −1 −1 1 −1 1 −1 1 −1 −1 1 1 1 1 1 −1 1 −1 −1 1 1 −1 |
| | −1 1 1 1 −1 −1 1 1 −1 −1 1 1 1 1 1 −1 −1 1 1 1 1 1 −1 −1 −1 1 −1 1 −1 −1 −1 −1 1 |
| | 1 1 −1 1 −1 −1 −1 1 −1 1 1 1 1 1 −1 1 −1 −1 1 −1 −1 1 1 −1 1 −1 −1 1 −1 −1 −1 |
| | −1 1 1 −1 1 1 1 1 −1 −1 −1 −1 1 1 1 1 1 −1 1 −1 −1 1 −1 1 −1 1 −1 −1 1 1 −1 1 −1 |
| | −1 −1 −1 −1 1 1 1 −1 1 −1 1 −1 1 1 −1 1 −1 −1 −1 −1 −1 −1 1 1 1 −1 −1 −1 1 −1 1 |
| | 1 1 1 −1 1 −1 1 1 −1 −1 −1 1 −1 1 1 1 1 1 1 1 1 −1 −1 −1 −1 1 1 1 1 −1 1 1 −1 1 |
| | −1 1 −1 1 1 −1 −1 −1 −1 1 1 −1 1 −1 −1 1 1 −1 1 1 1 1 −1 −1 −1 1 −1 1 1 −1 −1 1 |
| | −1 1 −1 1 −1 −1 1 −1 −1 −1 −1 1 −1 −1 −1 1 −1 1 −1 −1 −1 1 1 1 −1 1 1 1 1 1 1 1 |
| | 1 −1 1 −1 1 1 −1 1 1 −1 1 −1 −1 1 1 1 −1 −1 1 1 1 −1 1 −1 −1 1 −1 1 1 1 −1 1 −1 1 |
| | 1 −1 1 −1 1 −1 1 1 −1 1 1 −1 1 −1 1 −1 1 1 1 1 −1 −1 −1 −1 1 −1 1 −1 1 1 1 −1 −1 |
| | 1 1 1 −1 −1 −1 −1 −1 1 1 −1 −1 1 1 1 1 −1 −1 −1 −1 −1 1 −1 −1 1 −1 1 1 1 1 1 −1 |
| | 1 1 −1 −1 −1 1 1 1 −1 1 1 −1 1 1 −1 −1 1 1 −1 1 1 −1 −1 −1 1 1 1 1 1 −1 −1 −1 1 |
| | −1 −1 1 −1 −1 1 −1 −1 −1 1 1 −1 −1 1 −1 1 1 1 −1 1 1 1 1 1 −1 −1 −1 1 −1 1 1 1 |
| | −1 −1 −1 −1 −1 1 −1 −1 −1 −1 −1 1 −1 1 1 −1 1 −1 −1 −1 1 1 1 −1 −1 −1 −1 −1 |
| | −1 −1 1 1 −1 −1 1 1 −1 1 1 −1 1 −1 −1 1 −1 1 1 −1 −1 1 1 −1 1 1 −1 1 1 1 1 −1 −1 |
| | −1 1 1 −1 1 −1 1 −1 1 −1 1 1 −1 −1 −1 1 1 −1 −1 −1 −1 −1 1 1 1 1 1 −1 1 −1 1 −1 |
| | −1 1 1 −1 1 1 −1 1 −1 1 1 1 1 −1 −1 −1 1 1 1 1 1 1 1 1 −1 1 1 1 −1 −1 −1 1 −1 1 |
| | −1 1 1 1 −1 −1 −1 −1 1 −1 1 1 1 1 −1 1 −1 −1 −1 −1 −1 1 −1 1 −1 −1 1 1 1 −1 −1 |
| | −1 −1 −1 1 −1 1 −1 1 −1 −1 −1 1 1 −1 −1 −1 −1 1 1 1 −1 −1 1 1 −1 1 1 1 −1 −1 1 |
| | 1 1 −1 1 −1 1 −1 −1 1 −1 −1 1 −1 1 1 1 −1 −1 1 −1 −1 1 −1 −1 1 −1 −1 −1 −1 −1 |
| | −1 −1 −1 1 −1 −1 −1 −1 1 1 −1 −1 −1 −1 −1 1 1 −1 −1 1 −1 −1 1 −1 1 1 1 1 −1 −1 |
| | −1 1 1 −1 −1 1 1 −1 −1 1 −1 −1 1 −1 −1 1 −1 1 1 −1 −1 1 1 1 −1 1 −1 −1 −1 −1 −1 |
| | 1 −1 −1 1 −1 1 −1 −1 1 1 1 −1 −1 1 1 −1 1 1 −1 1 −1 1 −1 −1 1 −1 1 1 −1 −1 −1 1 |
| | 1 1 −1 −1 1 1 1 −1 −1 −1 1 1 1 1 1 1 −1 −1 −1 1 −1 −1 1 1 1 1 −1 1 1 −1 −1 1 −1 1 |
| | −1 −1 −1 −1 −1 1 −1 1 1 −1 −1 1 −1 −1 −1 −1 −1 1 1 −1 −1 −1 1 1 −1 1 −1 1 1 1 1 |
| | 1 −1 −1 −1 −1 1 −1 −1 −1 1 −1 −1 −1 1 −1 −1 1 1 −1 1 −1 1 1 −1 1 1 −1 −1 −1 1 1 |
| | −1 1 −1 −1 1 −1 1 −1 −1 −1 −1 −1 −1 −1 −1 1 1 −1 1 −1 −1 1 −1 −1 −1 1 −1 1 −1 |
| | −1 −1 −1 −1 1 −1 −1 −1 −1 −1 −1 1 1 1 1 −1 1 1 1 1 1 1 1 1 1 −1 −1 1 −1 1 −1 −1 |
| | 1 1 −1 −1 −1 −1 −1 −1 −1 −1 1 1 1 1 1 −1 −1 −1 −1 −1 1 1 1 −1 1 −1 −1 1 1 1 1 |
| | −1 1 1 1 −1 −1 −1 −1 −1 −1 −1 −1 1 1 −1 −1 1 −1 1 1 1 1 −1 1 1 −1 −1 1 1 1 1 −1 |
| | 1 −1 −1 1 −1 −1 1 −1 1 1 −1 1 −1 1 1 1 −1 1 1 1 −1 −1 1 1 1 −1 −1 1 1 −1 1 −1 1 1 |
| | −1 −1 1 1 −1 1 1 1 −1 1 1 −1 1 1 1 −1 1 −1 1 1 −1 1 1 −1 −1 1 −1 1 −1 −1 1 1 −1 1 |
| | 1 −1 −1 1 1 1 −1 −1 1 1 1 1 1 1 −1 −1 −1 1 1 1 1 1 −1 −1 1 −1 −1 −1 −1 1 1 −1 1 |
| | −1 −1 1 −1 1 1 1 −1 −1 1 1 1 1 −1 1 −1 1 1 1 −1 −1 −1 1 1 −1 −1 −1 1 −1 1 −1 −1 |
| | 1 −1 1 −1 −1 −1 −1 1 1 −1 −1 −1 −1 1 −1 1 −1 1 −1 1 1 −1 −1 1 1 −1 −1 1 −1 −1 |
| | −1 1 −1 1 1 −1 −1 1 1 1 1 1 1 −1 1 −1 −1 1 −1 1 1 −1 −1 −1 −1 −1 1 −1 1 −1 −1 |
| | −1 1 −1 −1 1 −1 −1 −1 1 1 1 −1 −1 −1 −1 1 1 −1 1 −1 1 1 −1 −1 −1 1 1 1 −1 1 −1 |
| | 1 1 1 1 1 −1 −1 1 1 1 −1 1 1 −1 1 1 −1 1 −1 1 −1 −1 −1 1 1 1 1 1 1 −1 −1 1 −1 −1 |
| | −1 −1 −1 −1 −1 1 1 1 −1 1 −1 1 1 −1 1 −1 −1 1 1 1 1 −1 −1 1 −1 −1 1 −1 −1 −1 −1 |
| | 1 −1 1 −1 −1 −1 −1 −1 −1 −1 1 −1 1 −1 −1 1 1 −1 1 −1 −1 1 1 −1 1 −1 −1 1 −1 1 1 |
| | −1 1 −1 1 −1 −1 −1 1 −1 −1 1 1 −1 1 1 −1 1 −1 −1 −1 1 1 1 1 1 −1 −1 1 1 1 −1 −1 |
| | −1 −1 1 −1 1 −1 1 −1 −1 −1 −1 −1 −1 −1 1 1 −1 −1 −1 −1 −1 1 −1 1 −1 1 1 1 −1 1 |
| | −1 1 1 1 1 1 1 1 1 1 −1 1 −1 −1 1 1 1 −1 −1 1 −1 −1 −1 1 1 1 −1 1 −1 1 1 −1 −1 1 |
| | −1 1 −1 −1 −1 1 1 1 −1 −1 −1 1 1 −1 −1 −1 −1 1 1 −1 1 −1 1 −1 1 −1 −1 −1 −1 −1 |
| | 1 −1 −1 1 1 −1 −1 −1 −1 −1 −1 1 1 1 1 −1 −1 −1 1 1 −1 −1 −1 −1 −1 −1 −1 1 1 −1 |
| | 1 −1 1 −1 −1 −1 1 −1 1 −1 1 −1 −1 −1 1 −1 1 −1 −1 1 −1 −1 −1 1 −1 1 1 1 −1 −1 1 |
| | −1 1 1 1 −1 −1 −1 −1 −1 −1 1 −1 −1 1 1 −1 1 −1 1 −1 1 1 1 1 1 1 −1 −1 −1 1 −1 1 |
| | −1 1 1 −1 1 −1 −1 1 −1 1 −1 −1 1 1 −1 −1 1 1 −1 −1 1 1 −1 −1 −1 1 1 −1 1 1 1 −1 |
| | 1 −1 1 −1 −1 −1 1 1 −1 1 −1 1 1 −1 1 −1 −1 1 −1 −1 1 −1 1 −1 1 1 −1 −1 −1 −1 1 |
| | −1 1 1 −1 1 −1 −1 1 −1 1 1 1 1 1 1 1 −1 −1 1 −1 1 1 1 1 1 1 1 1 1 1 −1 −1 −1 −1 |
| | −1 −1 1 1 1 −1 −1 1 −1 −1 1 −1 −1 −1 1 −1 −1 1 1 1 1 1 1 −1 −1 1 1 −1 1 −1 1 −1 |
| | −1 1 1 −1 −1 1 1 1 1 1 1 1 1 1 −1 −1 −1 1 1 −1 1 −1 −1 1 1 −1 −1 −1 1 1 1 1 1 −1 |
| | 1 1 1 −1 1 −1 1 1 −1 −1 −1 −1 −1 −1 1 −1 1 1 1 1 −1 −1 −1 1 −1 1 −1 1 −1 1 1 −1 |
| | 1 −1 1 −1 1 −1 1 1 1 1 −1 1 −1 1 1 1 1 −1 1 1 −1 −1 −1 −1 1 1 1 −1 1 1 −1 −1 −1 1 |
| | 1 −1 −1 −1 1 1 1 1 −1 −1 −1 1 −1 −1 1 −1 1 −1 −1 −1 1 −1 −1 1 1 1 −1 1 −1 −1 1 |
| | 1 1 −1 1 1 1 −1 1 1 1 1 −1 −1 −1 1 −1 −1 −1 −1 −1 −1 1 −1 1 −1 −1 −1 1 1 1 1 −1 |
| | 1 1 −1 −1 −1 −1 −1 −1 1 −1 −1 −1 1 1 1 1 1 −1 1 1 −1 1 1 −1 −1 −1 1 1 1 −1 −1 |
| | −1 −1 1 −1 1 1 −1 −1 −1 1 1 1 1 1 1 1 −1 1 1 1 −1 1 1 1 −1 −1 1 −1 −1 −1 −1 −1 |
| | −1 1 −1 1 1 1 −1 1 −1 −1 −1 1 −1 1 −1 −1 1 1 1 −1 1 1 −1 −1 −1 1 −1 1 −1 −1 −1 |
| | −1 −1 −1 1 −1 −1 1 1 1 −1 −1 1 1 −1 −1 −1 −1 1 1 −1 1 1 −1 −1 1 1 1 1 1 1 1 −1 |
| | −1 −1 −1 1 −1 −1 1 −1 −1 −1 1 −1 1 1 −1 1 −1 1 1 −1 −1 −1 1 −1 −1 −1 1 1 −1 −1 |
| | −1 −1 1 −1 −1 −1 −1 −1 −1 1 −1 −1 1 −1 −1 −1 −1 −1 −1 1 1 1 −1 1 1 1 −1 −1 −1 |
| | −1 −1 1 1 −1 1 −1 1 1 −1 1 1 1 1 −1 1 −1 1 −1 1 1 1 −1 1 1 1 1 −1 −1 1 −1 −1 −1 1 |
| | 1 1 1 −1 −1 1 −1 1 1 −1 1 1 −1 −1 1 −1 −1 1 −1 1 −1 1 −1 −1 1 −1 1 1 −1 1 1 1 1 |
| | −1 1 1 −1 −1 1 −1 −1 1 −1 −1 1 1 −1 1 −1 1 −1 −1 −1 1 1 −1 −1 1 1 1 1 −1 1 1 −1 |
| | −1 −1 1 1 −1 1 1 1 1 −1 −1 1 1 1 1 −1 −1 −1 1 −1 −1 −1 1 1 −1 1 1 −1 1 1 1 1 1 1 |
| | −1 1 −1 1 −1 1 −1 −1 1 −1 −1 −1 1 −1 −1 −1 1 −1 1 −1 1 −1 −1 1 −1 −1 1 1 1 −1 1 |
| | 1 −1 1 −1 −1 −1 −1 −1 −1 −1 −1 1 −1 1 1 −1 1 −1 1 1 1 1 −1 1 1 1 1 −1 −1 −1 −1 |
| | −1 1 −1 1 −1 −1 1 −1 −1 −1 −1 1 1 1 −1 1 1 −1 1 1 1 1 1 1 1 −1 −1 1 1 −1 1 1 −1 |
| | −1 −1 −1 −1 1 1 −1 1 1 1 −1 −1 −1 1 1 1 −1 −1 −1 1 1 1 1 −1 −1 −1 −1 1 −1 1 1 |
| | −1 1 1 1 1 −1 −1 −1 −1 −1 −1 1 1 −1 1 −1 1 1 1 −1 1 1 −1 1 −1 1 −1 −1 1 1 −1 1 |
| | −1 1 1 −1 −1 −1 −1 −1 1 −1 −1 1 −1 −1 −1 1 1 −1 1 −1 −1 1 −1 −1 1 −1 −1 1 1 1 1 |
| | 1 1 1 −1 −1 1 1 1 −1 1 −1 1 1 1 1 −1 1 −1 1 −1 −1 1 −1 −1 −1 1 1 1 −1 1 1 −1 1 −1 |
| | 1 −1 1 −1 1 −1 −1 1 −1 −1 1 −1 −1 −1 1 −1 1 −1 1 1 −1 −1 −1 1 1 1 1 −1 −1 1 −1 |
| | −1 −1 −1 1 −1 1 1 −1 1 −1 1 −1 −1 1 −1 −1 −1 −1 −1 1 −1 −1 −1 1 −1 1 1 −1 1 1 |
| | −1 1 −1 1 1 −1 1 1 −1 1 1 1 1 1 −1 1 1 −1 −1 1 −1 1 1 1 −1 −1 1 −1 1 −1 −1 −1 −1 |
| | 1 1 1 1 −1 −1 −1 1 −1 1 −1 −1 1 1 1 1 −1 1 −1 1 1 −1 1 −1 −1 −1 −1 1 1 1 1 −1 1 1 |
| | 1 −1 −1 1 1 −1 −1 1 1 −1 −1 1 −1 1 −1 −1 −1 −1 1 −1 −1 1 −1 1 1 −1 1 −1 −1 −1 1 |
| | −1 −1 −1 −1 1 1 1 1 1 1 1 −1 1 −1 −1 −1 1 −1 −1 1 1 −1 −1 −1 −1 1 1 1 1 −1 −1 1 |
| | 1 1 1 1 −1 1 1 1 −1 −1 1 1 1 1 1 1 1 1 −1 1 −1 −1 −1 −1 1 −1 1 −1 1 1 1 1 1 1 1 −1 |
| | 1 1 1 1 −1 1 1 1 1 −1 1 1 −1 −1 −1 1 −1 1 1 1 −1 −1 1 1 −1 1 1 1 1 1 1 1 −1 1 −1 1 |
| | −1 −1 −1 1 1 1 −1 −1 1 −1 1 −1 1 1 1 −1 −1 −1 1 −1 −1 1 −1 −1 −1 1 −1 −1 −1 −1 |
| | 1 1 −1 −1 1 1 −1 1 −1 1 1 −1 1 −1 1 −1 −1 −1 −1 1 −1 1 −1 1 −1 −1 1 1 −1 −1 1 |
| | −1 −1 1 1 −1 −1 −1 −1 1 −1 −1 1 −1 1 −1 −1 −1 −1 1 −1 1 −1 −1 1 −1 1 −1 1 1 −1 |
| | 1 −1 1 1 1 1 1 −1 1 1 −1 1 1 1 1 −1 1 −1 −1 1 1 1 −1 1 −1 −1 −1 1 −1 −1 −1 1 1 −1 |
| | 1 −1 1 1 1 −1 −1 −1 −1 1 1 −1 1 1 −1 1 −1 1 1 −1 −1 −1 −1 1 −1 −1 −1 −1 1 1 1 |
| | −1 1 −1 1 1 1 −1 −1 −1 −1 −1 −1 −1 1 −1 1 −1 1 −1 1 −1 −1 1 1 −1 −1 −1 1 −1 1 |
| | −1 1 1 1 1 1 −1 −1 −1 1 −1 −1 −1 1 −1 1 1 1 1 −1 −1 −1 −1 1 1 −1 −1 1 −1 −1 1 1 |
| | −1 1 1 −1 1 1 1 −1 1 −1 −1 −1 −1 1 −1 1 1 −1 1 1 −1 −1 −1 −1 1 1 1 1 −1 1 −1 1 1 |
| | −1 −1 1 −1 −1 1 −1 −1 −1 −1 −1 1 1 −1 1 1 1 1 1 −1 1 −1 −1 1 1 1 1 1 1 −1 1 1 −1 |
| | −1 −1 −1 1 −1 −1 −1 1 −1 1 1 1 −1 1 −1 −1 1 −1 −1 1 1 1 −1 −1 −1 −1 1 1 1 1 1 1 |
| | −1 −1 −1 −1 1 −1 1 −1 −1 −1 1 −1 1 −1 −1 −1 1 −1 −1 −1 1 −1 −1 −1 −1 −1 1 1 |
| | −1 −1 1 −1 1 −1 −1 1 −1 −1 −1 1 1 −1 1 1 1 1 −1 1 −1 1 1 −1 1 1 1 −1 −1 −1 −1 |
| | −1 −1 1 1 1 1 1 1 −1 1 −1 1 1 1 1 −1 −1 −1 −1 −1 1 1 −1 −1 −1 −1 1 1 1 1 1 1 1 1 |
| | −1 −1 −1 1 −1 1 1 −1 1 −1 −1 1 1 −1 1 1 −1 −1 −1 −1 1 −1 1 −1 −1 −1 −1 1 1 −1 1 |
| | 1 −1 1 1 −1 1 −1 1 1 1 −1 1 −1 −1 −1 −1 −1 −1 −1 1 1 1 1 −1 −1 1 −1 1 −1 1 1 1 1 |
| | 1 −1 1 1 1 −1 1 1 −1 1 −1 1 1 1 1 1 1 −1 1 −1 −1 −1 −1 −1 1 1 −1 −1 −1 −1 −1 −1 |
| | 1 1 −1 −1 −1 −1 1 −1 −1 1 1 −1 −1 −1 1 1 −1 1 −1 −1 −1 1 1 −1 1 1 1 1 1 −1 −1 1 |
| | −1 1 −1 −1 −1 −1 −1 −1 1 1 1 1 1 −1 1 1 −1 −1 −1 −1 −1 1 −1 −1 −1 1 −1 −1 −1 |
| | −1 1 −1 1 −1 1 −1 1 −1 1 −1 1 −1 1 1 −1 1 −1 −1 1 1 −1 −1 −1 −1 −1 1 1 −1 1 −1 |
| | −1 −1 −1 1 −1 −1 −1 1 −1 −1 1 −1 −1 −1 −1 −1 1 −1 1 1 1 −1 −1 −1 1 −1 −1 −1 1 |
| | −1 −1 −1 1 1 1 1 1 1 −1 1 −1 −1 −1 1 1 1 1 1 1 1 1 1 −1 1 1 1 1 1 −1 1 1 −1 1 −1 |
| | −1 1 −1 −1 1 −1 −1 1 −1 1 1 1 1 1 −1 1 −1 1 −1 −1 −1 −1 −1 1 −1 1 −1 1 −1 1 1 |
| | 1 1 1 1 1 1 −1 1 1 −1 1 −1 −1 −1 1 −1 1 −1 1 1 −1 1 1 1 1 −1 −1 1 1 −1 −1 −1 −1 1 |
| | −1 1 1 1 1 1 −1 −1 −1 1 1 1 −1 1 1 −1 −1 −1 −1 −1 −1 −1 1 −1 −1 −1 −1 −1 −1 −1 |
| | −1 1 1 1 −1 −1 −1 −1 1 1 1 −1 −1 1 −1 1 1 1 −1 1 1 −1 −1 1 −1 1 1 −1 1 −1 1 1 −1 |
| | 1 1 1 −1 1 1 −1 −1 1 −1 −1 −1 −1 1 1 −1 −1 1 −1 1 1 −1 −1 −1 1 −1 1 1 −1 −1 1 1 |
| | −1 −1 1 1 1 −1 1 1 −1 −1 1 1 1 1 1 −1 −1 −1 −1 1 1 −1 1 1 1 −1 −1 1 −1 1 1 1 1 1 |
| | −1 −1 1 1 −1 1 1 1 1 −1 −1 1 −1 −1 1 −1 1 1 −1 1 1 −1 1 1 1 −1 −1 −1 1 −1 1 1 −1 |
| | 1 1 1 1 1 1 −1 −1 1 1 −1 −1 1 1 −1 1 −1 −1 1 1 1 1 1 −1 −1 −1 1 1 −1 −1 −1 1 1 −1 |
| | −1 −1 −1 1 −1 1 1 −1 −1 1 −1 1 1 −1 −1 −1 −1 1 1 1 1 1 −1 −1 1 −1 1 1 −1 1 −1 1 |
| | −1 1 1 1 −1 1 −1 −1 1 −1 1 −1 1 1 1 1 1 1 −1 1 1 1 −1 −1 1 −1 −1 1 1 −1 −1 −1 1 |
| | −1 −1 −1 −1 1 −1 1 1 −1 −1 1 1 −1 1 −1 1 1 1 −1 −1 1 1 1 1 1 −1 −1 1 −1 −1 1 1 1 |
| | 1 1 −1 1 1 −1 −1 1 1 −1 1 1 1 1 −1 1 −1 −1 −1 −1 1 −1 −1 1 1 1 −1 −1 −1 −1 −1 |
| | −1 1 1 −1 −1 1 1 1 −1 1 −1 −1 1 1 −1 1 1 1 −1 1 −1 −1 −1 1 −1 −1 1 −1 1 −1 −1 1 |
| | −1 −1 −1 −1 −1 −1 1 −1 −1 −1 1 −1 −1 1 1 1 −1 −1 1 −1 1 −1 −1 1 −1 −1 1 −1 1 |
| | −1 −1 −1 −1 −1 1 1 −1 1 −1 1 −1 1 1 1 −1 −1 1 −1 1 1 −1 1 −1 −1 1 1 1 −1 1 −1 1 |
| | 1 1 −1 1 1 −1 −1 1 1 −1 1 −1 −1 1 −1 −1 1 1 1 1 1 −1 −1 −1 −1 −1 −1 −1 1 −1 −1 |
| | 1 1 −1 −1 1 1 −1 −1 −1 −1 −1 −1 1 −1 −1 1 −1 1 1 −1 −1 1 −1 −1 −1 1 1 1 1 1 1 1 |
| | −1 −1 −1 1 −1 −1 −1 −1 1 1 1 −1 −1 1 1 1 −1 1 1 1 1 −1 −1 −1 −1 1 −1 −1 1 1 1 |
| | −1 1 1 −1 −1 1 −1 −1 1 1 1 1 1 1 −1 1 −1 1 −1 −1 1 −1 1 1 1 1 −1 1 −1 −1 1 1 −1 1 |
| | 1 −1 1 1 −1 1 1 −1 1 1 1 −1 1 1 1 −1 −1 −1 1 −1 −1 1 1 1 −1 1 1 1 1 1 −1 1 −1 −1 |
| | −1 −1 1 1 −1 −1 1 −1 −1 −1 −1 −1 1 −1 1 −1 −1 −1 −1 1 −1 1 1 1 1 −1 −1 1 −1 −1 |
| | 1 1 −1 1 −1 −1 −1 1 −1 −1 1 −1 −1 1 −1 1 1 1 1 1 1 −1 1 −1 1 1 −1 −1 −1 −1 1 1 1 |
| | −1 −1 −1 −1 −1 1 −1 −1 1 1 −1 1 1 −1 −1 1 −1 −1 −1 −1 −1 −1 −1 −1 −1 1 −1 −1 |
| | 1 −1 −1 1 1 −1 −1 −1 −1 −1 1 −1 1 1 −1 1 1 1 −1 1 −1 −1 1 1 1 −1 −1 −1 1 −1 −1 |
| | −1 −1 −1 1 −1 −1 1 1 1 1 −1 −1 1 1 −1 −1 −1 1 −1 −1 1 −1 −1 −1 −1 1 −1 −1 1 −1 |
| | −1 1 1 1 1 −1 −1 1 −1 1 −1 −1 −1 1 1 −1 1 −1 −1 −1 −1 1 1 1 −1 1 1 1 −1 1 1 −1 |
| | −1 −1 −1 1 −1 1 1 1 −1 −1 −1 −1 1 −1 −1 −1 1 1 1 −1 1 1 1 −1 −1 1 1 −1 1 −1 1 |
| | −1 1 −1 1 −1 1 −1 −1 −1 −1 1 1 1 −1 −1 1 −1 −1 −1 1 −1 −1 −1 1 1 −1 −1 1 1 1 −1 |
| | 1 1 1 1 1 1 −1 −1 −1 1 1 −1 −1 1 −1 1 −1 1 1 1 −1 1 1 1 −1 1 −1 1 1 1 1 −1 −1 1 1 |
| | −1 1 −1 1 1 1 1 1 1 1 −1 −1 −1 1 1 1 −1 −1 −1 −1 −1 1 1 1 1 1 1 −1 1 1 1 −1 −1 |
| | 1 1 1 −1 −1 1 −1 1 1 −1 −1 −1 1 1 −1 1 −1 1 −1 −1 1 1 1 1 1 1 −1 −1 −1 −1 −1 1 1 |
| | −1 1 1 −1 1 −1 −1 −1 −1 −1 1 1 −1 1 1 −1 −1 1 −1 −1 1 1 −1 −1 1 1 1 −1 1 −1 1 |
| | −1 1 −1 −1 −1 −1 1 −1 −1 −1 −1 −1 1 1 1 −1 −1 −1 −1 −1 −1 1 −1 1 −1 1 −1 −1 1 |
| | −1 1 −1 1 1 1 −1 −1 1 −1 −1 −1 −1 1 1 1 −1 −1 −1 −1 1 −1 −1 −1 −1 −1 1 −1 −1 |
| | −1 −1 1 1 1 1 −1 −1 1 −1 −1 1 1 1 −1 −1 −1 1 −1 1 1 −1 −1 −1 1 1 −1 −1 1 1 −1 1 |
| | −1 −1 −1 −1 1 1 −1 1 1 1 −1 1 −1 −1 1 −1 −1 −1 −1 1 −1 1 1 1 −1 −1 1 1 1 −1 1 1 |
| | −1 −1 −1 −1 1 1 −1 1 1 1 1 1 1 −1 −1 −1 −1 −1 −1 −1 −1 1 −1 1 −1 1 1 −1 −1 −1 |
| | −1 −1 1 1 1 1 −1 1 1 −1 −1 1 1 −1 −1 −1 1 1 1 −1 1 1 1 −1 1 −1 1 −1 −1 1 −1 1 −1 |
| | −1 1 −1 −1 1 1 −1 −1 −1 1 1 1 −1 −1 −1 1 −1 −1 1 −1 1 1 1 −1 1 1 1 −1 −1 −1 −1 |
| | 1 −1 1 −1 −1 1 −1 −1 1 1 1 1 −1 1 −1 −1 1 1 1 1 −1 −1 −1 1 −1 1 1 1 1 1 −1 −1 1 |
| | −1 1 1 1 −1 −1 1 1 −1 −1 −1 1 1 −1 −1 −1 1 −1 −1 1 −1 1 1 −1 1 1 1 −1 1 1 1 1 1 |
| | −1 1 1 1 −1 −1 −1 −1 1 1 −1 −1 −1 −1 1 1 −1 −1 1 1 −1 −1 1 1 1 1 −1 1 −1 1 −1 |
| | −1 −1 −1 1 −1 −1 1 1 −1 1 −1 −1 1 1 1 −1 −1 −1 −1 1 −1 −1 1 1 −1 1 1 1 1 1 −1 1 |
| | 1 1 1 1 −1 −1 −1 −1 1 1 1 −1 1 1 1 1 −1 1 −1 1 1 1 −1 1 1 1 1 1 1 1 −1 1 1 −1 −1 |
| | −1 1 −1 −1 −1 1 −1 1 −1 −1 1 −1 1 1 1 −1 −1 −1 −1 1 1 1 −1 1 −1 −1 1 −1 −1 1 −1 |
| | −1 −1 −1 1 1 −1 −1 −1 1 1 1 1 1 1 −1 1 1 1 −1 1 −1 −1 −1 −1 −1 1 1 1 1 −1 −1 1 1 |
| | −1 −1 1 −1 −1 −1 −1 1 1 1 1 1 −1 −1 −1 1 1 1 1 −1 1 −1 1 1 1 1 1 −1 1 −1 1 1 1 −1 |
| | −1 1 −1 1 −1 1 1 −1 1 −1 −1 −1 1 1 −1 1 −1 −1 1 1 1 1 −1 1 −1 −1 −1 −1 1 1 1 1 1 |
| | −1 1 1 1 1 −1 −1 1 −1 1 1 1 1 −1 −1 1 1 −1 −1 1 1 1 |
| 10 | −1 −1 −1 −1 −1 −1 −1 −1 −1 −1 −1 −1 −1 1 1 1 1 −1 1 1 −1 1 −1 −1 −1 1 1 1 1 −1 |
| | −1 1 1 1 −1 1 1 1 1 −1 −1 −1 −1 −1 −1 1 −1 1 1 1 1 1 −1 1 1 1 −1 1 1 1 −1 1 −1 −1 |
| | −1 −1 1 −1 1 −1 −1 −1 1 1 −1 1 1 −1 1 −1 −1 −1 1 −1 −1 1 −1 1 1 −1 −1 −1 1 −1 1 |
| | −1 1 −1 −1 1 1 1 −1 −1 −1 1 −1 1 1 1 −1 1 1 −1 1 −1 1 −1 −1 −1 −1 −1 1 1 1 1 1 |
| | −1 1 1 −1 −1 1 −1 −1 1 1 −1 −1 1 1 −1 −1 1 −1 1 1 1 −1 1 1 1 1 1 1 1 1 1 −1 1 1 |
| | −1 −1 −1 1 1 1 −1 −1 −1 1 1 1 −1 −1 1 −1 −1 1 1 −1 1 −1 −1 −1 1 1 −1 1 1 −1 −1 |
| | −1 −1 −1 −1 1 −1 −1 1 −1 1 −1 1 −1 1 −1 −1 −1 −1 −1 −1 −1 −1 1 −1 −1 1 1 −1 1 |
| | 1 1 1 −1 −1 −1 1 −1 1 1 1 −1 −1 1 −1 1 1 −1 −1 1 1 1 −1 1 −1 1 1 1 1 1 −1 −1 −1 |
| | −1 1 −1 1 1 1 −1 1 1 −1 −1 −1 1 −1 1 1 −1 1 −1 −1 1 1 −1 −1 1 1 1 −1 −1 −1 −1 |
| | −1 −1 −1 −1 1 −1 −1 −1 1 −1 1 −1 −1 1 1 1 1 1 −1 −1 1 1 −1 1 1 1 1 1 1 1 1 1 1 1 |
| | 1 −1 1 1 1 −1 −1 1 −1 −1 −1 1 1 −1 1 1 1 −1 1 −1 1 1 −1 −1 1 1 1 −1 1 1 1 1 1 −1 |
| | −1 −1 1 1 1 1 −1 −1 1 1 −1 −1 1 1 −1 −1 −1 1 1 1 −1 −1 −1 −1 1 1 −1 1 −1 −1 1 |
| | −1 −1 −1 1 1 −1 −1 1 −1 −1 −1 1 −1 1 1 −1 −1 −1 −1 −1 −1 1 −1 1 1 −1 1 1 −1 −1 |
| | −1 1 1 −1 −1 1 −1 −1 −1 −1 −1 1 1 1 1 −1 1 1 1 1 −1 −1 1 −1 1 −1 −1 1 −1 1 −1 1 |
| | −1 1 −1 1 −1 −1 −1 1 1 −1 −1 1 1 1 1 1 1 1 1 −1 −1 1 −1 1 1 −1 1 1 −1 1 1 −1 1 1 |
| | −1 1 −1 −1 1 −1 1 −1 −1 −1 1 1 −1 1 −1 −1 1 −1 1 1 1 1 1 −1 −1 1 −1 −1 −1 −1 −1 |
| | −1 −1 −1 1 1 1 1 1 1 1 −1 −1 1 −1 1 −1 −1 1 1 1 −1 1 1 −1 −1 −1 1 1 −1 1 −1 −1 |
| | −1 1 −1 1 −1 1 1 −1 −1 −1 −1 1 1 1 1 −1 1 1 1 −1 −1 −1 1 1 −1 −1 1 −1 1 1 −1 −1 |
| | −1 1 −1 −1 −1 1 −1 1 −1 1 −1 1 1 −1 1 1 1 1 1 1 1 −1 −1 1 1 −1 −1 −1 −1 1 −1 1 1 |
| | 1 1 −1 1 −1 1 −1 −1 1 1 1 1 1 1 1 1 1 1 1 −1 −1 1 1 −1 1 −1 −1 1 1 −1 1 −1 −1 1 1 |
| | −1 −1 −1 −1 1 −1 1 −1 1 1 −1 −1 1 1 1 1 −1 1 1 −1 1 1 1 −1 1 −1 1 −1 1 −1 1 −1 1 |
| | 1 −1 1 1 −1 1 1 1 −1 1 −1 −1 −1 1 −1 −1 1 1 −1 1 −1 1 −1 −1 1 1 −1 −1 −1 1 −1 1 |
| | 1 1 1 1 −1 −1 −1 1 −1 −1 1 −1 1 1 −1 1 −1 1 −1 −1 1 1 1 1 −1 1 1 1 −1 −1 1 1 1 −1 |
| | 1 −1 −1 −1 −1 1 −1 −1 −1 −1 −1 −1 −1 −1 −1 −1 1 1 −1 1 −1 1 −1 1 1 1 1 1 1 1 −1 |
| | 1 −1 −1 −1 1 −1 −1 1 −1 −1 1 −1 −1 1 −1 −1 −1 1 −1 −1 −1 −1 1 1 −1 1 −1 −1 −1 |
| | 1 −1 −1 −1 1 1 1 1 −1 1 −1 −1 1 1 1 1 1 1 1 −1 1 1 1 1 1 1 −1 1 −1 −1 −1 −1 1 −1 |
| | 1 1 −1 −1 1 −1 1 1 −1 1 −1 −1 −1 1 1 −1 −1 −1 −1 −1 1 −1 1 1 1 −1 1 1 1 −1 −1 1 |
| | 1 −1 1 1 −1 1 −1 1 −1 −1 −1 1 −1 1 1 −1 −1 1 1 −1 −1 −1 −1 −1 −1 −1 1 −1 −1 1 1 |
| | 1 1 1 1 −1 1 −1 1 −1 1 1 1 −1 −1 −1 1 1 1 −1 −1 −1 −1 −1 1 −1 1 1 1 1 1 1 1 1 1 1 |
| | −1 1 −1 1 −1 −1 −1 1 −1 1 −1 −1 −1 1 −1 1 −1 1 1 1 −1 −1 −1 −1 −1 1 −1 1 −1 1 1 |
| | 1 −1 −1 1 −1 −1 1 1 −1 −1 −1 −1 −1 −1 −1 −1 −1 −1 1 −1 −1 1 −1 −1 1 1 −1 −1 |
| | −1 1 1 −1 −1 1 −1 1 −1 −1 −1 −1 −1 1 −1 1 −1 1 1 −1 −1 −1 1 1 1 1 −1 1 1 −1 −1 |
| | 1 −1 −1 −1 1 −1 −1 −1 −1 −1 1 −1 1 1 1 −1 −1 1 1 −1 1 −1 1 1 −1 −1 −1 1 1 1 −1 |
| | −1 1 1 1 1 1 1 1 1 1 −1 1 −1 −1 −1 −1 −1 −1 1 1 1 1 1 1 −1 −1 −1 1 1 −1 −1 1 −1 |
| | −1 1 −1 −1 1 −1 −1 1 1 −1 −1 1 1 1 −1 1 −1 −1 −1 1 1 −1 −1 1 1 −1 1 1 1 −1 −1 |
| | −1 1 −1 1 1 1 1 1 1 −1 −1 1 1 1 1 1 −1 −1 −1 1 1 1 −1 −1 −1 1 −1 1 −1 −1 −1 1 −1 |
| | −1 −1 1 1 −1 1 −1 1 1 1 1 −1 −1 −1 1 1 −1 −1 1 1 −1 1 −1 1 −1 −1 1 −1 −1 −1 −1 |
| | −1 1 1 −1 −1 −1 1 −1 1 −1 1 −1 1 1 1 1 1 1 −1 −1 1 −1 1 1 1 1 1 −1 −1 −1 −1 −1 |
| | −1 1 1 −1 1 1 −1 1 1 −1 1 1 1 1 −1 −1 −1 1 1 1 1 1 1 1 1 1 −1 −1 −1 −1 −1 1 1 −1 |
| | −1 −1 −1 1 1 −1 −1 −1 −1 −1 1 1 −1 1 1 1 1 −1 −1 −1 −1 −1 1 1 −1 1 −1 −1 1 −1 1 |
| | −1 1 1 1 1 1 1 1 1 1 −1 −1 1 −1 −1 1 −1 1 −1 1 1 −1 1 −1 1 −1 −1 −1 −1 1 1 1 1 −1 |
| | −1 −1 −1 −1 1 −1 1 1 −1 1 1 1 −1 −1 1 −1 1 −1 −1 1 1 −1 −1 1 1 1 1 −1 −1 −1 1 1 |
| | −1 1 −1 1 −1 −1 −1 −1 1 −1 1 1 −1 1 1 −1 1 −1 1 1 1 1 1 1 1 1 −1 −1 −1 1 1 1 1 1 |
| | −1 1 1 1 1 1 −1 1 1 −1 1 −1 1 −1 −1 1 −1 −1 1 −1 −1 1 −1 1 −1 1 −1 1 1 −1 −1 −1 |
| | 1 1 −1 1 −1 1 −1 1 −1 −1 1 1 −1 1 1 −1 −1 −1 1 1 1 1 1 −1 1 −1 1 1 1 1 −1 1 1 −1 |
| | 1 1 −1 1 1 −1 −1 −1 −1 1 1 −1 −1 1 1 −1 1 −1 −1 −1 −1 1 1 1 −1 1 1 −1 1 −1 1 −1 |
| | 1 −1 −1 −1 −1 −1 1 −1 −1 1 1 1 1 −1 1 −1 1 1 −1 −1 −1 −1 −1 −1 −1 1 1 1 1 1 −1 |
| | 1 −1 −1 −1 1 1 1 1 −1 1 1 1 1 1 −1 1 −1 −1 1 −1 −1 1 −1 −1 1 1 1 −1 1 1 −1 1 1 1 |
| | 1 1 1 1 1 −1 1 1 1 1 −1 1 −1 1 1 1 −1 1 −1 1 1 1 1 −1 1 −1 −1 1 1 1 −1 1 1 1 1 −1 1 |
| | −1 −1 −1 1 −1 −1 −1 −1 −1 1 1 1 1 1 1 1 1 −1 1 −1 −1 1 −1 −1 −1 −1 −1 1 −1 −1 |
| | −1 −1 −1 1 1 1 −1 1 1 1 −1 1 1 1 1 −1 −1 −1 1 −1 −1 1 1 −1 1 −1 −1 −1 −1 1 −1 1 |
| | −1 1 −1 1 1 1 −1 1 1 −1 1 −1 −1 −1 −1 −1 1 1 1 −1 −1 −1 1 −1 −1 1 −1 −1 −1 −1 1 |
| | 1 1 1 1 1 1 −1 1 1 −1 1 1 1 1 −1 −1 1 1 1 1 −1 −1 1 −1 −1 −1 −1 −1 1 −1 −1 1 −1 |
| | −1 1 −1 −1 −1 −1 −1 −1 −1 1 −1 1 1 −1 1 −1 −1 −1 −1 −1 −1 −1 1 −1 1 −1 −1 1 |
| | −1 1 1 −1 1 1 1 1 −1 −1 −1 −1 1 1 1 −1 −1 1 −1 −1 1 −1 −1 1 −1 1 1 1 −1 1 −1 1 |
| | −1 1 −1 −1 −1 1 1 1 −1 1 1 −1 −1 1 −1 −1 −1 −1 −1 −1 −1 1 1 1 1 −1 −1 1 −1 1 1 |
| | 1 −1 −1 −1 −1 1 −1 1 1 1 1 1 1 −1 1 1 1 1 −1 −1 −1 1 1 −1 1 1 1 −1 −1 1 1 1 1 −1 |
| | −1 −1 1 −1 −1 1 −1 −1 1 −1 1 1 −1 −1 1 −1 −1 1 1 1 1 1 1 1 −1 −1 1 1 1 −1 −1 −1 |
| | −1 1 1 −1 −1 −1 −1 1 1 1 −1 −1 −1 1 −1 1 1 −1 −1 1 1 1 −1 −1 −1 1 1 −1 −1 1 1 1 |
| | 1 −1 1 1 1 1 1 1 1 −1 −1 −1 1 −1 −1 1 1 1 1 −1 −1 1 1 1 1 −1 1 1 −1 −1 1 1 −1 −1 |
| | 1 1 1 −1 1 1 −1 −1 1 −1 1 −1 −1 −1 1 1 1 −1 −1 −1 −1 −1 −1 −1 1 1 −1 −1 1 −1 −1 |
| | −1 1 1 1 1 −1 1 1 −1 1 1 −1 −1 1 −1 −1 1 1 1 −1 1 1 1 1 1 1 −1 −1 1 −1 −1 1 1 1 |
| | −1 1 −1 1 1 1 −1 1 −1 −1 1 1 1 1 −1 −1 1 −1 −1 1 −1 −1 1 1 1 1 1 1 −1 −1 −1 1 −1 |
| | −1 −1 1 1 1 1 1 1 −1 −1 −1 −1 1 −1 −1 −1 1 −1 −1 1 1 1 −1 1 1 1 −1 1 1 −1 1 −1 |
| | −1 1 −1 −1 1 −1 −1 −1 1 1 −1 −1 −1 −1 −1 −1 −1 1 1 −1 1 1 −1 −1 1 −1 1 −1 −1 1 |
| | 1 1 1 1 1 −1 1 1 1 −1 1 −1 −1 −1 1 1 −1 1 1 1 −1 −1 −1 1 1 1 1 1 −1 −1 1 1 1 −1 1 |
| | 1 −1 1 −1 −1 1 1 −1 1 −1 1 1 1 −1 1 1 −1 −1 1 −1 −1 1 −1 −1 −1 1 −1 1 −1 −1 1 |
| | −1 1 1 1 1 1 1 −1 1 −1 1 1 −1 1 1 1 −1 1 −1 1 1 1 −1 1 1 −1 1 1 −1 −1 −1 1 −1 1 |
| | −1 1 1 −1 1 1 −1 1 −1 1 −1 1 1 1 −1 −1 1 1 1 1 1 1 −1 1 1 −1 −1 1 −1 1 1 1 −1 1 |
| | −1 1 1 1 −1 −1 1 −1 1 −1 1 −1 1 −1 1 1 −1 −1 1 −1 1 −1 −1 −1 −1 1 1 −1 1 1 −1 1 |
| | 1 1 1 1 1 −1 1 −1 1 −1 −1 1 1 −1 1 1 1 −1 −1 1 −1 −1 1 −1 1 −1 −1 1 −1 1 1 −1 −1 |
| | 1 1 1 1 1 −1 1 −1 −1 1 −1 1 1 −1 −1 −1 −1 1 1 −1 −1 −1 1 −1 1 1 1 −1 1 −1 −1 1 |
| | −1 −1 1 −1 1 1 1 1 1 −1 1 1 −1 −1 1 1 −1 1 1 1 1 1 −1 1 1 1 −1 −1 1 1 −1 −1 1 −1 |
| | 1 1 −1 −1 1 1 −1 −1 1 −1 −1 −1 1 −1 −1 1 −1 −1 1 1 −1 1 −1 1 1 1 1 1 1 −1 1 −1 |
| | −1 1 −1 1 −1 −1 −1 −1 1 −1 1 1 1 1 1 −1 −1 1 1 −1 −1 −1 1 1 −1 1 −1 −1 1 1 −1 1 |
| | 1 −1 1 1 1 1 −1 1 −1 1 1 −1 −1 1 −1 −1 −1 1 −1 1 −1 −1 −1 −1 1 1 −1 −1 1 −1 1 |
| | −1 −1 1 −1 −1 1 1 −1 −1 −1 −1 1 −1 −1 −1 1 1 1 1 1 −1 −1 −1 −1 1 −1 −1 1 1 −1 |
| | −1 −1 −1 1 1 −1 −1 1 −1 −1 1 −1 1 1 −1 −1 −1 −1 −1 1 −1 −1 1 −1 −1 −1 −1 −1 |
| | −1 1 1 −1 1 −1 1 1 1 1 1 −1 −1 1 −1 1 −1 −1 −1 1 1 −1 −1 −1 −1 1 1 −1 1 −1 −1 |
| | −1 −1 −1 −1 −1 −1 −1 1 −1 1 −1 −1 −1 −1 1 1 1 −1 1 −1 −1 1 −1 −1 1 1 1 1 1 −1 |
| | −1 −1 −1 −1 1 −1 1 −1 −1 1 1 −1 1 −1 −1 1 −1 −1 −1 −1 1 −1 −1 −1 1 −1 1 −1 1 1 |
| | 1 1 −1 −1 −1 1 −1 −1 −1 1 −1 1 1 1 −1 1 −1 1 1 −1 −1 −1 1 1 −1 −1 −1 1 −1 −1 1 |
| | −1 −1 −1 1 1 1 1 −1 −1 1 −1 1 −1 1 −1 −1 1 1 1 1 −1 −1 1 1 −1 1 −1 1 −1 1 −1 −1 |
| | −1 1 −1 1 −1 1 −1 1 −1 −1 1 1 −1 −1 1 −1 −1 1 −1 1 −1 −1 −1 −1 1 1 1 1 1 −1 −1 |
| | −1 1 −1 −1 −1 −1 1 1 1 −1 −1 −1 1 1 1 1 1 −1 1 −1 1 −1 1 1 −1 1 −1 −1 −1 1 −1 1 |
| | −1 −1 1 −1 −1 1 1 1 −1 −1 −1 −1 1 −1 1 −1 −1 1 1 −1 −1 −1 −1 1 1 1 −1 1 −1 1 −1 |
| | −1 −1 −1 1 −1 −1 1 −1 1 −1 1 1 1 −1 −1 1 1 −1 1 1 1 1 −1 1 1 1 −1 −1 1 −1 1 −1 1 |
| | 1 1 −1 1 −1 1 −1 −1 1 −1 −1 −1 1 −1 1 1 1 1 −1 −1 1 −1 −1 1 1 1 1 1 −1 1 −1 −1 |
| | −1 −1 1 1 1 1 −1 1 −1 −1 −1 −1 1 1 −1 1 −1 1 1 1 −1 1 −1 −1 −1 1 1 1 1 1 1 1 1 −1 |
| | −1 −1 −1 1 1 1 −1 1 1 −1 −1 −1 1 −1 −1 1 −1 1 1 1 1 −1 1 1 1 1 −1 −1 −1 1 −1 |
| | 1 −1 −1 −1 1 −1 −1 1 1 1 −1 −1 1 1 −1 −1 −1 −1 −1 1 1 1 −1 1 1 −1 −1 1 1 −1 −1 |
| | −1 1 1 −1 −1 −1 −1 −1 1 1 −1 1 −1 1 1 −1 −1 1 −1 −1 1 1 −1 1 1 1 −1 1 −1 −1 |
| | −1 −1 −1 −1 1 −1 1 1 1 −1 1 −1 1 −1 −1 −1 −1 −1 −1 −1 1 1 −1 −1 −1 −1 −1 −1 |
| | −1 −1 1 −1 1 −1 1 −1 −1 1 −1 −1 −1 −1 1 1 1 −1 1 1 1 1 −1 1 1 −1 −1 1 1 1 −1 1 1 |
| | −1 1 1 −1 1 1 1 −1 −1 −1 −1 −1 −1 1 −1 −1 −1 1 1 −1 −1 −1 −1 1 −1 −1 1 −1 1 1 |
| | −1 1 1 1 −1 −1 −1 −1 1 −1 1 −1 1 1 1 −1 1 1 −1 −1 −1 −1 −1 1 1 1 −1 −1 1 −1 −1 |
| | −1 −1 −1 1 1 −1 1 −1 1 −1 −1 1 1 1 −1 −1 1 1 −1 1 −1 −1 −1 −1 −1 1 1 −1 −1 −1 |
| | −1 −1 1 −1 −1 1 1 −1 −1 −1 1 1 1 −1 1 −1 −1 1 −1 1 1 1 1 −1 −1 −1 1 1 1 −1 1 1 1 |
| | −1 −1 −1 1 1 1 −1 1 −1 −1 −1 −1 1 1 −1 −1 −1 1 1 −1 1 1 1 1 1 1 1 −1 1 1 1 −1 1 1 |
| | −1 −1 1 −1 1 1 −1 −1 1 −1 −1 −1 1 1 1 −1 −1 1 1 1 −1 1 1 1 −1 −1 −1 −1 1 1 −1 |
| | −1 1 −1 1 1 −1 1 −1 1 −1 1 1 1 1 −1 1 1 −1 −1 1 −1 1 −1 1 −1 1 1 −1 1 −1 1 1 1 −1 |
| | −1 −1 1 −1 −1 −1 −1 1 −1 1 −1 −1 1 −1 1 −1 −1 1 1 −1 −1 −1 1 1 1 1 1 −1 −1 −1 1 |
| | 1 −1 −1 −1 −1 −1 1 1 1 1 1 1 −1 1 −1 1 1 1 1 1 1 1 −1 −1 −1 −1 −1 −1 1 −1 −1 1 1 |
| | 1 −1 1 1 −1 −1 1 1 1 −1 −1 1 −1 1 −1 1 1 −1 −1 1 −1 −1 1 −1 −1 1 1 −1 1 1 1 1 1 |
| | −1 −1 1 1 −1 1 −1 1 1 1 −1 −1 1 −1 −1 −1 1 −1 −1 1 1 −1 1 1 1 −1 −1 −1 −1 −1 1 |
| | 1 −1 −1 1 −1 1 1 1 1 −1 1 1 −1 1 −1 −1 1 1 1 1 −1 1 −1 −1 −1 −1 −1 1 −1 1 1 −1 1 |
| | −1 1 −1 −1 −1 1 1 1 1 −1 1 −1 1 1 1 1 −1 −1 1 −1 1 −1 1 1 −1 1 1 −1 −1 −1 1 −1 |
| | −1 −1 1 1 1 −1 1 1 −1 1 1 −1 −1 1 1 −1 1 1 −1 1 1 −1 −1 −1 1 1 1 −1 1 −1 1 1 −1 1 |
| | −1 −1 1 1 1 1 1 1 −1 −1 1 1 −1 −1 1 −1 1 −1 −1 −1 1 −1 1 −1 −1 1 1 −1 1 1 −1 1 |
| | −1 1 1 −1 −1 1 1 −1 1 1 1 −1 1 −1 1 −1 −1 −1 1 −1 −1 −1 −1 −1 −1 1 1 1 −1 −1 1 |
| | −1 1 −1 −1 −1 −1 −1 −1 −1 1 −1 −1 −1 −1 1 1 −1 1 1 −1 −1 1 1 1 −1 −1 −1 −1 1 |
| | −1 −1 −1 −1 1 −1 1 −1 1 1 −1 1 1 1 1 −1 1 1 −1 1 −1 1 1 1 1 −1 1 1 1 1 1 −1 −1 −1 |
| | −1 1 1 1 1 1 1 −1 1 1 1 1 1 −1 −1 1 −1 1 1 −1 −1 1 −1 1 −1 1 1 −1 1 −1 −1 −1 −1 |
| | −1 1 −1 1 −1 −1 1 −1 −1 1 −1 1 −1 −1 1 1 1 1 −1 1 −1 1 −1 −1 −1 −1 1 1 −1 1 −1 |
| | −1 1 1 −1 −1 1 −1 1 −1 −1 1 1 −1 1 1 1 1 −1 1 −1 1 −1 −1 −1 1 1 1 −1 −1 1 −1 −1 |
| | −1 1 −1 1 1 1 −1 −1 −1 1 1 1 1 −1 −1 −1 1 −1 −1 −1 −1 −1 1 1 −1 1 1 1 −1 −1 −1 |
| | −1 1 1 1 −1 1 −1 −1 −1 −1 −1 1 −1 −1 1 −1 1 1 −1 −1 1 1 −1 1 1 −1 −1 1 −1 −1 1 |
| | −1 1 −1 1 −1 −1 1 −1 −1 1 −1 1 1 −1 1 1 −1 −1 −1 −1 1 −1 −1 −1 1 −1 1 1 1 1 1 |
| | −1 1 −1 1 −1 1 −1 −1 −1 −1 1 1 −1 −1 −1 −1 1 −1 1 −1 −1 1 −1 −1 −1 −1 1 −1 1 |
| | −1 1 −1 −1 1 1 −1 −1 −1 −1 −1 1 1 −1 −1 1 1 1 1 1 −1 1 1 −1 1 −1 −1 −1 −1 1 1 1 |
| | 1 1 1 −1 −1 1 1 1 −1 1 −1 −1 1 −1 1 −1 1 1 −1 1 1 1 −1 −1 1 1 1 −1 −1 −1 −1 −1 1 |
| | −1 −1 1 1 1 −1 −1 1 −1 −1 −1 −1 1 1 1 −1 −1 1 1 1 1 −1 1 1 1 −1 1 1 1 1 1 −1 −1 1 |
| | 1 1 1 −1 1 −1 −1 −1 1 −1 1 −1 −1 −1 −1 −1 1 −1 −1 −1 1 1 1 1 −1 −1 −1 −1 1 −1 |
| | −1 1 −1 −1 −1 −1 1 −1 1 1 1 −1 −1 −1 −1 −1 1 1 1 −1 1 −1 −1 −1 1 −1 1 −1 1 −1 |
| | −1 −1 −1 1 −1 1 −1 −1 1 1 1 −1 −1 −1 −1 −1 1 1 −1 1 1 −1 1 −1 −1 1 1 −1 −1 −1 1 |
| | 1 −1 1 1 −1 1 1 1 −1 1 1 −1 −1 1 1 1 1 −1 1 −1 −1 1 1 −1 1 1 1 −1 1 1 −1 −1 −1 1 |
| | 1 1 1 −1 −1 1 −1 −1 −1 1 −1 1 −1 1 −1 −1 1 −1 1 −1 −1 1 −1 −1 −1 −1 −1 −1 1 −1 |
| | −1 1 −1 −1 −1 1 −1 −1 1 −1 1 1 1 −1 −1 1 1 −1 −1 −1 1 1 1 1 −1 −1 −1 −1 −1 −1 |
| | −1 1 1 1 −1 1 −1 1 1 1 −1 −1 −1 −1 1 −1 −1 1 1 1 −1 −1 −1 −1 −1 −1 1 −1 1 −1 1 |
| | 1 1 1 −1 1 −1 1 −1 1 1 1 1 −1 −1 1 −1 −1 −1 1 1 1 −1 1 1 1 1 1 −1 1 −1 1 1 −1 −1 |
| | −1 1 −1 −1 −1 −1 −1 1 −1 −1 1 1 −1 1 −1 1 1 −1 1 1 1 1 −1 −1 1 −1 1 1 −1 1 −1 |
| | −1 1 1 1 −1 1 1 −1 1 −1 1 1 1 −1 −1 1 1 −1 −1 1 1 1 1 −1 1 −1 1 1 1 −1 −1 −1 1 1 |
| | −1 −1 −1 −1 1 1 1 1 −1 −1 1 1 −1 1 1 1 −1 1 1 1 −1 −1 1 −1 −1 1 1 1 −1 −1 −1 1 1 |
| | −1 1 1 1 1 −1 1 1 −1 −1 −1 1 1 −1 −1 −1 −1 −1 −1 1 1 1 −1 −1 −1 −1 1 −1 1 1 −1 |
| | 1 1 1 1 −1 1 −1 −1 1 −1 −1 −1 1 −1 1 −1 1 1 −1 1 −1 −1 1 −1 −1 1 1 −1 −1 1 −1 1 |
| | −1 1 1 1 −1 −1 −1 1 −1 1 −1 −1 1 −1 −1 1 −1 1 1 −1 1 1 1 −1 1 −1 −1 1 1 −1 −1 |
| | −1 −1 −1 −1 1 −1 −1 −1 −1 1 −1 −1 1 1 1 1 1 −1 −1 1 −1 −1 1 1 −1 −1 1 −1 −1 −1 |
| | 1 1 −1 1 −1 1 −1 1 1 −1 1 1 1 −1 1 1 1 1 1 1 −1 1 1 −1 −1 −1 −1 1 1 −1 1 1 1 −1 |
| | −1 1 −1 1 1 −1 1 1 1 1 1 −1 −1 −1 −1 −1 1 1 1 −1 −1 −1 −1 −1 −1 1 1 1 −1 1 −1 |
| | −1 1 1 −1 1 1 −1 −1 1 1 1 1 −1 −1 −1 −1 1 −1 1 1 −1 −1 1 1 1 1 −1 −1 1 −1 1 −1 |
| | −1 −1 −1 1 −1 −1 1 1 1 −1 1 −1 −1 −1 1 −1 −1 −1 1 −1 1 1 −1 −1 1 −1 −1 −1 −1 1 |
| | 1 −1 1 −1 1 −1 1 −1 1 1 1 −1 −1 −1 −1 1 1 −1 1 1 −1 1 −1 1 1 1 −1 1 1 1 −1 1 −1 1 |
| | −1 −1 1 1 −1 −1 1 1 −1 1 −1 −1 1 −1 1 1 −1 1 1 −1 1 −1 −1 1 1 1 −1 −1 1 −1 1 1 |
| | −1 1 −1 1 1 1 1 1 −1 1 1 −1 1 1 1 −1 −1 −1 1 −1 −1 1 1 1 −1 −1 −1 1 −1 −1 1 1 −1 |
| | −1 −1 −1 −1 1 −1 −1 −1 1 −1 −1 1 −1 1 −1 1 −1 −1 −1 −1 −1 1 1 −1 1 1 −1 −1 −1 |
| | −1 1 −1 1 −1 1 −1 −1 −1 1 −1 −1 1 1 −1 −1 −1 1 −1 1 −1 1 1 1 1 1 −1 −1 1 1 1 −1 |
| | −1 1 −1 1 1 1 1 −1 1 −1 −1 1 −1 1 −1 1 −1 −1 1 1 −1 1 −1 −1 −1 −1 −1 −1 1 −1 −1 |
| | 1 1 −1 −1 1 1 1 1 1 −1 −1 1 −1 1 1 1 −1 1 −1 −1 1 1 −1 1 −1 −1 −1 1 −1 −1 1 1 1 1 |
| | −1 1 1 1 1 −1 1 1 −1 1 1 1 1 1 −1 1 1 −1 −1 −1 1 −1 1 −1 −1 1 −1 1 −1 1 1 1 −1 1 |
| | 1 1 −1 −1 −1 1 −1 1 −1 1 1 1 −1 1 −1 −1 −1 −1 1 1 1 −1 −1 1 −1 1 1 −1 −1 −1 1 1 |
| | −1 −1 1 1 −1 −1 −1 1 −1 1 −1 −1 1 1 1 −1 1 −1 −1 −1 −1 −1 −1 −1 −1 1 1 −1 1 1 1 |
| | −1 1 −1 −1 1 −1 −1 −1 −1 1 1 −1 −1 1 1 −1 −1 −1 −1 −1 1 −1 1 −1 1 −1 1 −1 −1 |
| | −1 1 −1 −1 −1 1 −1 −1 1 −1 −1 −1 1 −1 1 1 −1 1 −1 −1 −1 1 −1 −1 −1 −1 1 1 1 1 |
| | −1 −1 1 −1 −1 1 1 −1 1 1 −1 −1 1 −1 1 1 −1 1 1 −1 −1 1 −1 1 −1 1 1 1 1 −1 −1 1 1 |
| | −1 −1 1 −1 −1 −1 −1 −1 −1 1 1 1 1 −1 1 −1 −1 1 −1 1 1 1 −1 −1 −1 −1 −1 −1 1 1 |
| | −1 −1 1 −1 1 −1 1 1 −1 −1 −1 −1 −1 1 1 1 1 −1 1 −1 1 1 −1 1 −1 −1 −1 1 1 1 −1 |
| | −1 −1 1 −1 −1 −1 −1 −1 −1 1 −1 1 −1 −1 −1 1 1 1 1 1 −1 −1 1 −1 1 −1 1 −1 1 1 1 |
| | 1 −1 1 −1 −1 −1 1 1 −1 −1 −1 1 −1 1 −1 −1 −1 1 1 −1 −1 1 −1 1 1 1 −1 −1 1 1 1 |
| | −1 −1 1 −1 −1 1 1 1 1 −1 −1 1 −1 1 1 −1 −1 −1 −1 1 −1 −1 −1 −1 1 1 −1 −1 1 1 |
| | −1 1 1 −1 −1 −1 −1 −1 1 1 −1 −1 −1 1 1 1 −1 1 1 −1 1 −1 −1 −1 1 −1 1 1 −1 1 −1 |
| | 1 −1 1 −1 1 1 −1 −1 −1 −1 1 −1 1 1 −1 −1 −1 1 1 1 1 1 1 1 −1 1 −1 −1 1 1 −1 −1 |
| | −1 1 −1 −1 1 1 1 −1 1 −1 1 −1 1 −1 1 1 1 1 −1 −1 −1 −1 −1 −1 −1 −1 1 1 −1 −1 1 |
| | 1 −1 −1 1 −1 −1 1 1 −1 −1 −1 1 −1 −1 −1 1 1 −1 −1 1 1 1 −1 1 1 1 −1 1 −1 −1 1 |
| | −1 1 −1 −1 1 −1 1 −1 −1 −1 1 −1 −1 1 −1 1 −1 −1 −1 −1 −1 1 1 1 −1 1 −1 1 −1 1 |
| | −1 −1 1 1 1 1 1 −1 1 1 1 −1 −1 −1 1 −1 −1 −1 1 1 −1 1 1 1 1 1 −1 1 −1 1 −1 −1 −1 |
| | −1 −1 1 −1 1 1 1 1 −1 1 1 1 −1 −1 −1 −1 1 −1 −1 −1 1 1 −1 1 1 −1 1 1 −1 −1 1 1 1 |
| | 1 1 −1 −1 −1 −1 1 1 −1 1 1 1 1 −1 1 −1 −1 −1 −1 −1 −1 −1 1 1 1 −1 −1 −1 1 1 −1 |
| | 1 −1 1 1 −1 −1 −1 −1 1 1 −1 1 −1 1 −1 −1 −1 1 1 −1 1 −1 1 1 −1 1 −1 −1 1 −1 1 1 |
| | 1 −1 1 −1 −1 −1 1 −1 1 1 1 −1 −1 1 1 1 1 −1 1 −1 1 −1 1 −1 −1 1 −1 1 1 1 1 −1 1 |
| | −1 1 1 −1 1 1 −1 −1 1 −1 −1 −1 1 1 −1 −1 −1 1 −1 −1 −1 −1 −1 −1 −1 −1 1 −1 1 1 |
| | 1 −1 −1 −1 1 −1 1 1 −1 1 1 1 1 1 1 −1 −1 −1 1 −1 1 −1 1 1 −1 −1 1 −1 1 1 −1 −1 |
| | −1 −1 −1 −1 −1 −1 1 1 1 −1 1 1 1 1 1 1 1 −1 1 −1 1 −1 1 −1 1 −1 −1 1 −1 1 −1 1 1 |
| | −1 −1 1 1 −1 1 −1 1 −1 1 1 −1 −1 1 1 −1 −1 −1 1 −1 −1 −1 −1 1 −1 −1 −1 −1 1 1 |
| | −1 −1 1 −1 −1 −1 −1 1 1 1 1 −1 1 1 −1 −1 −1 −1 −1 −1 −1 1 −1 1 1 1 1 −1 −1 1 1 |
| | −1 1 1 −1 −1 1 1 −1 1 −1 −1 1 1 1 1 −1 −1 −1 −1 −1 1 1 1 1 −1 −1 −1 1 1 1 −1 −1 |
| | 1 1 −1 1 1 1 −1 −1 1 1 −1 1 −1 −1 1 −1 −1 1 −1 1 −1 1 1 1 1 −1 1 1 1 −1 1 −1 −1 1 |
| | 1 1 −1 −1 −1 1 1 1 1 1 1 −1 1 1 −1 1 1 −1 1 −1 −1 −1 −1 1 −1 1 1 1 −1 1 −1 −1 −1 |
| | −1 −1 1 1 −1 1 −1 −1 −1 −1 1 −1 −1 −1 1 −1 −1 −1 1 1 −1 −1 −1 1 1 −1 −1 −1 1 1 |
| | −1 1 −1 1 1 1 −1 −1 −1 −1 −1 −1 −1 1 −1 −1 −1 1 1 1 −1 −1 −1 −1 1 −1 −1 1 −1 1 |
| | −1 −1 1 1 −1 1 −1 1 1 −1 −1 1 1 1 1 1 1 1 −1 −1 −1 1 1 −1 1 1 −1 −1 −1 1 −1 −1 1 |
| | 1 1 1 1 −1 1 1 −1 −1 −1 −1 −1 1 −1 1 −1 −1 −1 1 −1 1 1 1 1 1 1 1 −1 1 1 −1 −1 1 1 |
| | 1 1 1 1 −1 −1 −1 −1 −1 −1 −1 −1 −1 1 −1 −1 −1 −1 −1 1 −1 1 −1 1 −1 −1 −1 −1 |
| | −1 −1 1 −1 1 −1 1 −1 1 1 −1 −1 1 1 1 −1 −1 1 1 1 −1 1 −1 1 −1 −1 1 1 1 −1 1 1 1 |
| | −1 −1 1 −1 1 1 1 1 1 1 −1 −1 −1 1 1 1 −1 1 −1 1 −1 −1 1 −1 1 −1 1 −1 −1 −1 1 −1 |
| | 1 1 1 −1 1 1 1 1 −1 1 1 1 −1 1 1 −1 1 1 −1 1 −1 1 −1 −1 1 1 −1 1 −1 1 −1 −1 −1 1 |
| | −1 −1 1 −1 −1 −1 −1 −1 1 1 1 −1 −1 1 1 −1 −1 −1 1 −1 1 1 −1 1 1 −1 1 1 1 1 1 −1 |
| | −1 1 −1 −1 1 −1 −1 −1 1 1 1 −1 −1 −1 1 1 −1 −1 −1 1 1 1 1 −1 1 −1 −1 −1 1 1 1 |
| | −1 −1 1 1 −1 −1 1 1 −1 1 −1 1 1 −1 1 −1 1 1 −1 1 −1 −1 −1 −1 1 1 −1 1 1 1 1 1 1 |
| | −1 −1 1 1 −1 1 1 −1 1 1 1 −1 −1 1 −1 −1 −1 −1 1 −1 1 −1 −1 −1 −1 1 −1 1 −1 1 1 |
| | 1 1 1 1 −1 1 1 −1 1 −1 −1 1 −1 1 1 −1 −1 1 −1 1 1 1 1 −1 −1 1 −1 1 1 1 1 −1 −1 −1 |
| | −1 1 1 −1 −1 −1 1 1 1 1 1 1 −1 −1 1 −1 1 −1 1 1 1 1 1 −1 1 1 1 1 1 1 1 1 −1 −1 1 1 |
| | 1 1 −1 −1 −1 −1 −1 −1 1 1 1 1 1 −1 −1 −1 −1 −1 −1 −1 1 −1 1 −1 1 1 −1 1 −1 1 1 |
| | −1 −1 −1 −1 −1 1 −1 1 1 −1 −1 1 1 −1 1 −1 −1 −1 1 1 1 1 1 −1 1 1 −1 1 1 −1 −1 |
| | −1 −1 −1 1 −1 −1 −1 −1 −1 −1 1 1 −1 −1 −1 1 1 −1 −1 1 1 1 −1 −1 1 1 −1 −1 1 −1 |
| | −1 1 −1 −1 −1 −1 −1 1 −1 1 −1 −1 −1 −1 −1 1 1 −1 −1 1 −1 −1 1 1 1 1 −1 1 1 −1 1 |
| | −1 1 −1 1 1 −1 −1 −1 1 −1 −1 1 −1 −1 1 1 1 1 −1 1 −1 −1 1 −1 −1 1 1 −1 1 1 −1 1 |
| | 1 −1 1 −1 1 1 −1 1 1 1 −1 −1 −1 1 1 −1 1 1 −1 1 −1 1 −1 1 −1 1 −1 −1 −1 −1 1 −1 |
| | −1 −1 −1 1 −1 −1 −1 1 1 1 −1 1 −1 −1 1 1 1 1 1 −1 1 −1 1 −1 −1 1 −1 −1 1 1 −1 1 |
| | −1 −1 1 1 1 −1 −1 −1 −1 1 1 1 −1 −1 −1 −1 −1 1 1 1 1 1 −1 −1 1 −1 −1 −1 1 −1 −1 |
| | −1 1 −1 1 −1 −1 −1 1 1 1 −1 1 −1 −1 −1 1 1 1 −1 1 1 1 −1 1 −1 1 1 −1 1 1 1 1 1 −1 |
| | 1 −1 −1 −1 −1 −1 1 1 1 1 −1 −1 1 1 1 1 1 1 1 −1 1 −1 1 1 1 −1 1 1 1 1 1 −1 1 1 1 1 |
| | −1 1 1 1 1 1 1 −1 −1 −1 −1 −1 1 −1 −1 −1 −1 1 −1 1 1 1 1 −1 −1 −1 1 −1 1 −1 1 |
| | −1 −1 −1 1 1 −1 1 1 1 1 −1 −1 1 −1 −1 1 −1 1 1 1 1 −1 −1 1 1 1 1 1 −1 1 −1 1 1 −1 |
| | 1 −1 1 −1 1 1 −1 1 −1 1 −1 1 −1 −1 1 −1 −1 1 1 1 1 −1 −1 −1 −1 1 1 1 1 −1 1 −1 1 |
| | −1 −1 1 −1 1 1 1 −1 −1 1 −1 −1 −1 −1 −1 −1 1 −1 1 1 −1 −1 1 −1 −1 1 −1 1 1 1 −1 |
| | −1 −1 1 −1 −1 1 −1 1 −1 −1 1 −1 −1 1 −1 −1 −1 −1 1 −1 −1 1 1 −1 1 1 −1 1 −1 −1 |
| | 1 −1 −1 −1 −1 −1 −1 −1 −1 −1 1 1 1 −1 −1 1 1 1 −1 −1 1 1 −1 1 1 −1 −1 −1 1 −1 1 |
| | 1 1 1 −1 −1 −1 −1 −1 1 −1 −1 1 −1 1 −1 −1 −1 1 −1 1 1 −1 1 1 1 −1 1 1 −1 1 1 1 1 |
| | −1 1 1 1 1 −1 1 −1 −1 1 1 −1 −1 1 1 −1 −1 −1 −1 1 1 −1 1 1 −1 −1 −1 1 1 −1 1 1 |
| | −1 −1 1 1 −1 −1 −1 −1 1 −1 −1 1 1 1 1 −1 −1 −1 1 1 1 1 −1 1 1 1 −1 1 −1 1 1 1 1 1 |
| | 1 −1 −1 −1 −1 1 1 −1 −1 1 1 1 1 −1 −1 1 1 1 −1 −1 1 1 1 1 1 −1 1 1 1 1 −1 −1 1 1 |
| | 1 −1 −1 −1 1 1 1 −1 1 1 −1 −1 −1 −1 −1 −1 1 1 −1 1 −1 −1 1 1 1 −1 1 −1 −1 1 −1 |
| | −1 −1 1 1 1 −1 1 −1 1 1 1 1 −1 −1 −1 −1 1 −1 −1 −1 −1 −1 −1 1 −1 −1 −1 −1 −1 |
| | −1 −1 1 −1 −1 1 −1 1 1 1 −1 1 1 1 −1 1 1 1 −1 −1 −1 −1 −1 1 −1 −1 −1 1 1 −1 1 |
| | −1 −1 1 1 1 1 1 −1 −1 −1 1 −1 1 −1 −1 1 −1 −1 −1 1 1 −1 1 1 −1 −1 1 −1 −1 −1 −1 |
| | 1 −1 −1 1 −1 −1 1 1 1 −1 −1 1 −1 1 −1 −1 1 −1 −1 −1 1 −1 −1 1 1 1 1 1 1 1 1 −1 1 |
| | 1 −1 1 −1 1 1 −1 1 −1 1 −1 −1 1 −1 1 1 −1 −1 −1 1 1 1 −1 1 1 1 1 −1 −1 1 −1 −1 |
| | −1 −1 1 1 −1 −1 −1 1 −1 −1 1 1 −1 −1 1 −1 −1 1 1 1 −1 −1 1 1 1 −1 −1 −1 1 −1 1 |
| | −1 1 −1 1 −1 1 1 1 −1 1 −1 −1 1 −1 1 1 −1 1 −1 −1 1 −1 1 −1 1 −1 1 1 1 −1 −1 1 |
| | −1 1 1 1 −1 1 1 −1 1 1 1 −1 −1 1 1 −1 −1 −1 −1 1 1 1 1 1 −1 1 1 1 −1 1 −1 1 −1 1 |
| | 1 1 −1 1 −1 1 1 −1 1 −1 1 1 1 1 −1 −1 1 1 1 −1 1 −1 1 1 −1 1 1 −1 1 1 −1 −1 1 −1 |
| | 1 1 1 1 1 −1 1 −1 −1 −1 1 −1 1 1 −1 −1 −1 1 −1 −1 1 1 −1 1 1 −1 −1 −1 −1 1 1 1 |
| | −1 1 1 1 −1 −1 1 1 1 1 1 −1 −1 1 1 1 1 1 1 −1 −1 1 −1 −1 −1 1 1 −1 −1 1 1 −1 −1 1 |
| | 1 −1 1 1 1 1 −1 −1 1 1 −1 1 −1 −1 −1 1 −1 1 1 1 1 −1 1 1 −1 −1 −1 −1 1 −1 −1 1 1 |
| | −1 1 −1 −1 1 −1 1 −1 −1 1 1 1 −1 −1 1 −1 −1 1 −1 1 1 −1 1 −1 −1 −1 −1 1 −1 −1 1 |
| | 1 −1 −1 1 −1 1 1 1 1 1 1 1 −1 −1 1 −1 −1 −1 −1 1 −1 −1 −1 −1 −1 1 −1 −1 −1 1 −1 |
| | 1 1 −1 1 1 −1 −1 1 1 1 −1 1 −1 −1 1 1 1 −1 1 −1 1 1 −1 −1 1 −1 1 −1 1 −1 −1 1 −1 |
| | 1 1 −1 1 −1 1 1 −1 1 1 −1 −1 −1 −1 −1 −1 −1 −1 −1 1 1 −1 −1 −1 1 −1 −1 −1 1 −1 |
| | −1 −1 1 −1 −1 −1 −1 −1 −1 −1 1 1 −1 1 −1 −1 −1 1 1 −1 −1 1 −1 −1 1 1 −1 1 −1 1 |
| | −1 1 1 1 −1 1 1 1 1 −1 −1 1 1 −1 −1 −1 −1 −1 −1 1 1 −1 −1 −1 −1 1 −1 −1 −1 −1 1 |
| | 1 1 −1 1 −1 1 1 −1 −1 −1 −1 1 −1 −1 1 −1 −1 1 −1 1 −1 −1 −1 1 1 1 1 −1 −1 −1 1 |
| | 1 −1 −1 −1 1 −1 1 1 −1 −1 1 −1 1 −1 −1 1 −1 1 1 1 −1 1 1 −1 −1 1 1 −1 1 −1 1 1 1 |
| | 1 −1 1 −1 1 1 1 1 1 −1 1 −1 −1 1 1 −1 1 −1 1 −1 1 −1 1 −1 1 −1 −1 1 1 1 −1 1 −1 1 |
| | −1 −1 −1 1 1 −1 −1 −1 1 1 1 −1 −1 1 −1 1 1 1 −1 −1 1 −1 1 −1 −1 −1 1 −1 −1 −1 |
| | −1 1 −1 1 1 −1 1 −1 −1 1 −1 −1 −1 1 −1 −1 −1 1 1 1 −1 −1 1 −1 1 −1 1 −1 −1 −1 1 |
| | 1 1 1 1 1 −1 1 −1 −1 1 1 1 −1 −1 1 1 1 1 −1 −1 1 1 −1 −1 −1 1 −1 −1 1 −1 1 −1 1 1 |
| | −1 −1 −1 1 −1 1 1 −1 −1 −1 −1 1 −1 1 −1 −1 −1 −1 −1 −1 1 −1 −1 −1 1 −1 −1 −1 |
| | −1 1 −1 −1 1 −1 1 1 1 1 1 1 1 1 −1 1 −1 1 1 −1 −1 1 1 −1 −1 1 1 −1 −1 1 1 1 1 1 1 |
| | −1 1 −1 −1 −1 1 1 −1 1 −1 1 −1 −1 1 −1 1 −1 −1 −1 −1 −1 −1 1 1 −1 −1 1 1 1 −1 1 |
| | −1 1 −1 1 1 1 1 1 −1 1 −1 1 1 1 −1 −1 1 1 1 −1 1 1 −1 −1 −1 −1 1 −1 1 1 1 −1 −1 1 |
| | −1 −1 1 −1 −1 −1 −1 1 1 −1 1 1 1 −1 1 1 −1 1 −1 1 1 −1 −1 −1 1 −1 1 −1 −1 −1 −1 |
| | 1 −1 −1 −1 1 1 −1 −1 1 −1 1 −1 1 −1 −1 −1 −1 1 1 −1 −1 −1 −1 1 1 1 1 −1 −1 −1 |
| | 1 −1 1 −1 −1 −1 −1 −1 −1 −1 −1 −1 −1 −1 1 −1 1 1 −1 −1 −1 −1 −1 1 1 −1 1 −1 1 |
| | 1 −1 1 1 −1 1 −1 −1 −1 1 1 −1 1 −1 −1 −1 −1 1 1 −1 −1 1 1 1 −1 −1 −1 1 −1 −1 −1 |
| | 1 −1 −1 1 1 −1 −1 1 1 −1 1 1 −1 1 −1 −1 −1 −1 −1 −1 1 1 −1 1 1 1 1 1 −1 −1 −1 1 |
| | −1 1 1 −1 1 −1 1 1 1 −1 1 −1 1 −1 1 1 −1 −1 1 −1 −1 −1 −1 −1 1 −1 1 1 −1 −1 −1 |
| | 1 −1 1 1 1 −1 −1 −1 −1 1 1 1 1 1 −1 −1 1 1 −1 −1 1 1 1 −1 −1 1 −1 −1 −1 1 1 1 1 1 |
| | 1 1 −1 −1 −1 −1 1 −1 1 −1 1 −1 1 −1 1 −1 1 −1 1 1 1 1 1 −1 −1 −1 1 1 −1 1 −1 −1 |
| | −1 −1 −1 1 −1 −1 −1 −1 1 1 1 1 1 −1 1 −1 1 −1 1 1 −1 −1 −1 −1 −1 −1 1 1 1 1 −1 |
| | −1 −1 −1 1 1 −1 1 −1 1 1 −1 −1 1 −1 1 1 1 −1 −1 −1 1 1 −1 1 −1 −1 1 −1 −1 1 1 1 |
| | −1 1 −1 −1 1 1 −1 −1 1 −1 −1 −1 −1 1 −1 1 1 −1 −1 −1 −1 1 1 1 −1 −1 1 1 −1 1 −1 |
| | 1 −1 −1 −1 −1 −1 −1 1 1 1 −1 1 1 −1 1 1 1 −1 1 1 1 −1 1 1 −1 −1 −1 −1 1 1 1 1 1 1 |
| | 1 1 1 1 −1 −1 −1 1 −1 1 1 1 1 −1 1 −1 −1 −1 −1 1 −1 −1 1 −1 −1 −1 1 1 −1 1 −1 |
| | −1 −1 1 1 1 −1 1 −1 1 −1 1 1 −1 1 1 −1 −1 1 1 −1 −1 1 −1 1 −1 1 −1 1 −1 −1 1 −1 |
| | −1 −1 1 1 1 1 1 −1 1 −1 −1 1 1 1 1 −1 1 1 −1 −1 −1 1 −1 −1 −1 −1 1 1 −1 −1 −1 |
| | −1 −1 −1 1 −1 1 −1 −1 1 1 1 1 −1 −1 −1 1 −1 1 1 −1 −1 −1 1 1 −1 1 1 1 −1 1 1 1 1 |
| | −1 1 −1 1 −1 1 −1 1 1 −1 1 −1 −1 1 1 −1 1 1 1 1 1 1 −1 1 1 1 |
| 11 | −1 −1 −1 −1 −1 −1 −1 −1 −1 −1 −1 −1 −1 1 1 1 1 −1 1 1 1 −1 −1 1 −1 1 1 −1 1 −1 |
| | −1 −1 1 1 −1 1 −1 −1 1 −1 −1 −1 −1 1 −1 −1 1 −1 1 −1 −1 1 −1 −1 −1 −1 1 −1 1 1 |
| | −1 1 1 1 1 −1 1 −1 1 −1 1 1 −1 1 −1 1 1 −1 −1 −1 1 −1 −1 −1 −1 −1 1 −1 −1 −1 −1 |
| | 1 1 −1 1 −1 1 1 −1 1 −1 1 1 1 1 −1 1 1 −1 1 −1 1 −1 1 −1 −1 1 −1 1 −1 −1 −1 −1 |
| | −1 1 1 −1 −1 −1 1 −1 −1 1 −1 −1 −1 1 1 −1 1 1 1 1 1 1 −1 1 −1 −1 1 −1 1 1 −1 −1 |
| | −1 −1 −1 1 −1 −1 1 −1 1 −1 1 −1 −1 −1 1 −1 −1 −1 −1 −1 1 1 1 −1 −1 −1 1 1 1 1 |
| | −1 −1 −1 1 1 −1 1 1 −1 −1 −1 −1 1 1 −1 −1 1 1 1 −1 1 1 1 1 1 −1 −1 −1 −1 −1 −1 |
| | 1 −1 1 1 −1 1 1 1 −1 −1 1 −1 −1 1 1 1 1 1 1 −1 −1 −1 1 1 −1 −1 −1 1 −1 1 −1 1 −1 |
| | 1 1 1 1 −1 −1 1 1 −1 1 −1 1 1 −1 −1 1 −1 1 −1 1 −1 −1 −1 1 1 −1 −1 −1 1 1 1 |
| | −1 1 −1 −1 1 −1 1 1 −1 1 −1 −1 −1 −1 1 −1 1 1 1 1 −1 1 −1 1 −1 1 −1 −1 1 −1 −1 |
| | −1 −1 −1 1 1 1 1 1 −1 1 −1 1 −1 −1 1 1 −1 1 −1 −1 −1 −1 −1 1 −1 −1 −1 1 −1 1 −1 |
| | −1 −1 −1 1 1 −1 1 1 1 −1 −1 −1 1 −1 −1 −1 1 −1 −1 1 1 1 1 1 1 −1 1 −1 1 1 1 1 −1 |
| | 1 1 1 1 −1 1 1 −1 −1 −1 −1 −1 −1 1 1 −1 1 1 −1 1 −1 1 −1 −1 1 1 1 1 1 −1 1 1 1 −1 |
| | 1 −1 −1 −1 −1 −1 −1 1 −1 1 −1 −1 −1 1 −1 1 1 −1 1 −1 1 −1 1 −1 1 −1 −1 1 1 −1 1 |
| | −1 1 −1 −1 −1 −1 1 −1 −1 −1 −1 −1 1 1 −1 1 −1 −1 −1 1 −1 1 1 1 1 1 1 1 −1 1 −1 |
| | 1 −1 1 −1 −1 −1 −1 −1 −1 1 1 1 1 −1 1 −1 1 −1 −1 −1 1 1 1 1 1 1 1 1 1 −1 1 −1 −1 |
| | −1 −1 −1 1 1 1 1 1 1 1 −1 1 1 1 1 1 1 1 1 1 1 −1 1 −1 1 −1 −1 −1 −1 −1 1 1 −1 1 |
| | −1 1 −1 1 −1 −1 −1 1 1 −1 1 −1 1 −1 −1 −1 1 −1 −1 −1 1 −1 1 1 −1 1 −1 −1 −1 1 |
| | −1 −1 1 −1 1 −1 −1 −1 1 −1 −1 1 1 1 1 −1 1 −1 1 1 −1 1 1 −1 −1 −1 −1 −1 1 1 −1 |
| | −1 −1 −1 1 −1 1 1 −1 1 1 −1 1 −1 1 1 −1 −1 1 −1 −1 −1 1 −1 1 1 1 1 1 −1 1 −1 1 1 |
| | −1 −1 1 1 −1 1 1 1 −1 −1 −1 −1 1 −1 −1 −1 −1 1 1 −1 −1 −1 1 1 1 −1 −1 1 −1 1 −1 |
| | 1 −1 1 1 −1 1 1 −1 −1 −1 1 −1 1 1 1 1 −1 −1 −1 −1 −1 −1 1 1 −1 1 1 −1 1 −1 −1 |
| | 1 −1 1 −1 1 −1 −1 1 1 −1 −1 1 1 −1 1 −1 1 1 1 1 1 −1 −1 −1 −1 −1 1 1 −1 1 −1 1 1 |
| | 1 −1 −1 1 −1 1 −1 −1 −1 −1 1 1 −1 −1 1 1 −1 1 1 1 −1 1 −1 −1 1 1 1 −1 −1 −1 1 1 |
| | 1 1 1 −1 −1 1 −1 1 1 1 1 −1 1 1 −1 1 1 1 −1 1 1 1 1 −1 −1 −1 1 1 1 −1 −1 −1 1 −1 |
| | −1 −1 −1 1 −1 1 −1 1 −1 1 −1 1 −1 −1 1 −1 −1 1 −1 −1 1 −1 −1 1 1 1 1 1 −1 1 −1 |
| | −1 −1 1 1 −1 1 −1 1 1 −1 −1 1 1 1 −1 1 1 1 −1 1 −1 −1 1 1 −1 −1 −1 −1 −1 −1 1 1 |
| | −1 −1 1 −1 1 1 −1 −1 −1 −1 1 −1 −1 −1 −1 −1 −1 −1 −1 1 1 −1 1 1 1 −1 −1 1 1 −1 |
| | −1 1 −1 −1 −1 −1 1 −1 −1 −1 1 1 −1 1 1 1 −1 1 1 −1 −1 1 −1 1 1 1 −1 1 1 −1 1 1 |
| | −1 −1 −1 −1 −1 −1 1 −1 −1 1 1 1 −1 −1 1 1 −1 −1 −1 −1 1 −1 1 −1 1 1 1 1 1 1 1 |
| | −1 1 1 1 −1 1 1 1 −1 −1 1 −1 −1 −1 −1 1 1 −1 1 1 −1 1 −1 −1 −1 −1 1 −1 −1 1 1 1 |
| | 1 −1 −1 1 1 1 1 1 −1 −1 1 1 1 −1 1 −1 1 −1 −1 1 1 1 −1 −1 −1 1 −1 1 1 1 1 1 1 −1 |
| | −1 1 −1 −1 1 1 −1 1 −1 1 1 1 1 −1 −1 −1 −1 1 1 1 1 1 1 1 −1 −1 1 1 1 −1 −1 1 1 −1 |
| | 1 1 −1 1 1 1 1 1 −1 −1 −1 1 1 −1 1 1 1 −1 −1 −1 −1 −1 −1 −1 −1 1 −1 1 −1 1 −1 |
| | −1 −1 −1 −1 1 −1 1 1 −1 −1 −1 −1 −1 1 1 −1 1 −1 −1 1 1 −1 1 −1 −1 1 1 −1 1 1 −1 |
| | 1 1 1 −1 1 −1 −1 1 −1 1 −1 −1 1 −1 1 1 −1 1 1 1 −1 −1 −1 −1 −1 1 −1 −1 1 1 −1 |
| | −1 1 1 −1 1 1 1 1 1 −1 −1 −1 −1 1 −1 1 −1 −1 −1 −1 1 −1 1 1 1 −1 −1 1 −1 −1 1 1 |
| | −1 1 1 1 1 1 −1 1 −1 −1 1 1 −1 −1 −1 1 −1 −1 1 −1 1 −1 1 1 1 −1 1 1 −1 1 −1 1 −1 |
| | −1 1 −1 1 1 1 1 −1 1 1 1 1 1 1 1 −1 1 1 −1 −1 1 1 −1 1 −1 1 1 −1 1 1 −1 1 1 −1 −1 |
| | −1 1 1 −1 1 1 −1 −1 1 −1 1 1 1 1 1 1 −1 −1 −1 −1 −1 1 −1 1 1 −1 −1 1 −1 −1 1 −1 |
| | 1 1 −1 1 1 −1 1 −1 −1 1 −1 −1 −1 1 −1 −1 −1 −1 −1 −1 −1 1 −1 1 −1 −1 1 −1 −1 1 |
| | −1 −1 −1 −1 −1 1 −1 −1 1 1 1 1 1 1 1 1 −1 1 −1 −1 1 −1 −1 1 −1 −1 1 1 −1 1 1 −1 |
| | −1 1 −1 −1 −1 1 1 −1 1 1 −1 1 1 1 1 −1 −1 −1 −1 −1 −1 −1 1 −1 1 1 1 1 −1 1 1 1 |
| | −1 1 1 1 1 −1 1 −1 1 1 −1 1 −1 −1 −1 −1 1 1 1 1 1 −1 1 1 −1 −1 −1 −1 1 1 1 1 1 1 |
| | −1 −1 −1 1 −1 −1 −1 −1 −1 1 1 −1 −1 −1 −1 −1 −1 1 1 1 −1 1 −1 −1 −1 −1 −1 1 |
| | −1 −1 1 1 −1 1 1 1 −1 −1 −1 1 1 −1 −1 1 1 1 1 1 −1 1 −1 −1 1 1 1 −1 −1 1 1 1 1 −1 |
| | −1 −1 −1 −1 −1 −1 −1 −1 1 1 −1 −1 −1 1 −1 1 1 −1 −1 1 −1 1 −1 −1 1 −1 −1 −1 1 |
| | 1 −1 1 −1 1 1 1 −1 1 1 −1 1 1 1 −1 −1 −1 1 1 1 −1 1 1 −1 −1 1 −1 −1 −1 1 −1 −1 1 |
| | 1 1 −1 1 1 −1 −1 1 1 1 −1 1 1 −1 −1 1 −1 1 −1 1 −1 1 −1 1 1 1 1 −1 1 1 1 −1 −1 1 |
| | 1 1 1 −1 −1 1 −1 −1 −1 1 1 −1 1 −1 −1 1 1 −1 −1 −1 −1 1 −1 1 1 1 1 1 −1 −1 1 1 1 |
| | 1 −1 −1 1 1 −1 −1 1 −1 1 1 −1 1 1 −1 1 1 −1 1 −1 1 1 1 −1 1 −1 1 1 1 −1 −1 1 −1 |
| | −1 −1 −1 −1 1 −1 1 −1 1 1 −1 1 −1 1 −1 1 −1 −1 −1 −1 1 −1 1 1 −1 −1 −1 1 1 1 1 |
| | 1 1 1 −1 −1 −1 1 1 −1 1 −1 1 −1 −1 1 1 −1 −1 1 −1 −1 1 −1 −1 −1 1 1 −1 −1 1 1 1 |
| | −1 −1 −1 1 1 −1 −1 1 −1 1 1 1 1 −1 −1 −1 −1 1 −1 1 1 1 −1 −1 −1 −1 −1 1 −1 1 1 |
| | 1 −1 1 −1 1 −1 −1 1 −1 −1 −1 −1 1 1 1 1 −1 −1 −1 1 1 1 1 1 −1 1 1 −1 1 −1 −1 1 |
| | −1 −1 1 1 −1 −1 1 1 −1 −1 1 1 1 −1 1 −1 −1 1 1 1 −1 1 −1 1 1 −1 −1 1 −1 1 1 1 −1 |
| | −1 1 −1 1 −1 1 −1 −1 1 −1 1 −1 1 −1 −1 −1 −1 −1 −1 −1 1 1 1 1 −1 −1 1 1 −1 1 −1 |
| | −1 1 −1 −1 −1 1 1 −1 −1 −1 1 1 −1 1 1 1 1 1 −1 −1 1 −1 1 −1 −1 1 −1 −1 1 1 1 −1 |
| | −1 1 1 1 −1 −1 −1 −1 1 1 −1 −1 1 −1 −1 −1 1 −1 1 −1 1 1 1 1 −1 −1 1 −1 −1 1 −1 |
| | −1 −1 −1 −1 −1 −1 −1 1 −1 −1 1 1 −1 1 −1 1 −1 −1 1 −1 1 −1 1 1 −1 −1 −1 1 1 −1 |
| | 1 −1 1 −1 1 1 1 −1 1 −1 −1 −1 −1 −1 1 1 −1 1 1 1 −1 1 1 1 −1 1 −1 −1 −1 1 −1 −1 |
| | 1 1 −1 −1 −1 1 1 1 −1 −1 −1 −1 1 −1 −1 1 1 1 1 1 −1 1 1 −1 −1 1 −1 1 1 −1 −1 1 1 |
| | 1 −1 1 −1 1 −1 1 1 1 1 1 1 −1 1 1 1 −1 −1 −1 1 −1 1 1 1 −1 1 1 −1 1 −1 −1 −1 −1 1 |
| | 1 −1 1 1 −1 −1 −1 −1 −1 1 −1 −1 −1 −1 1 −1 −1 1 −1 −1 −1 −1 1 1 1 −1 −1 −1 −1 |
| | −1 −1 1 1 −1 −1 −1 −1 1 1 1 1 −1 −1 −1 −1 1 1 1 −1 1 1 1 1 1 1 1 −1 −1 1 −1 −1 |
| | −1 −1 −1 1 1 1 −1 1 −1 1 1 −1 −1 −1 −1 1 1 −1 1 −1 1 1 1 1 −1 1 −1 −1 1 −1 −1 1 |
| | 1 −1 1 1 1 −1 1 −1 1 1 1 1 1 1 −1 1 −1 1 −1 −1 1 −1 −1 1 −1 1 1 −1 −1 −1 −1 1 1 |
| | −1 −1 −1 1 1 −1 −1 −1 1 1 −1 −1 1 1 1 −1 1 −1 1 1 1 1 1 −1 −1 1 −1 −1 1 −1 1 1 |
| | −1 −1 1 −1 1 1 1 1 −1 1 −1 −1 1 1 −1 1 1 1 −1 1 1 1 1 1 −1 −1 1 −1 −1 −1 −1 1 1 1 |
| | 1 1 −1 −1 1 −1 −1 1 1 1 1 −1 1 −1 −1 1 −1 1 −1 1 −1 −1 1 −1 −1 −1 1 −1 1 1 −1 |
| | −1 1 −1 −1 −1 −1 1 1 1 −1 1 −1 −1 −1 1 −1 1 −1 1 −1 1 −1 −1 1 −1 1 1 −1 −1 −1 1 |
| | −1 1 −1 1 −1 −1 1 1 1 1 1 1 1 1 1 1 −1 −1 −1 1 −1 1 1 −1 −1 −1 1 1 −1 1 1 1 −1 1 |
| | −1 −1 −1 1 1 −1 1 1 1 1 −1 1 −1 1 1 1 1 −1 −1 1 1 1 1 −1 1 −1 1 −1 1 1 1 1 −1 1 |
| | −1 1 −1 −1 −1 −1 1 1 1 −1 −1 1 1 −1 −1 −1 1 1 −1 1 1 −1 1 1 −1 1 −1 −1 1 1 −1 |
| | −1 1 1 1 −1 −1 1 −1 1 −1 1 1 1 1 −1 −1 −1 −1 −1 1 1 1 −1 −1 1 −1 1 1 −1 −1 1 −1 |
| | −1 −1 1 1 1 1 1 −1 −1 −1 1 1 1 −1 1 1 1 −1 1 −1 1 1 1 −1 1 1 −1 −1 1 1 −1 1 1 1 1 |
| | −1 −1 −1 −1 1 −1 −1 1 1 −1 1 1 −1 −1 −1 −1 −1 −1 −1 −1 −1 1 −1 −1 −1 −1 −1 1 |
| | 1 1 1 −1 −1 1 −1 −1 1 −1 1 −1 −1 −1 1 1 −1 1 1 −1 −1 −1 1 1 1 −1 1 −1 1 1 1 1 −1 |
| | −1 −1 1 1 1 1 −1 −1 1 1 1 −1 −1 −1 −1 −1 1 −1 −1 −1 1 −1 −1 −1 −1 −1 1 −1 1 −1 |
| | −1 1 −1 1 1 −1 −1 1 1 −1 1 1 −1 −1 −1 −1 1 −1 −1 −1 1 −1 −1 −1 1 −1 1 −1 −1 1 |
| | −1 1 1 1 −1 1 1 1 −1 1 −1 1 −1 1 −1 1 −1 1 −1 1 −1 −1 −1 −1 −1 1 1 1 1 −1 1 1 −1 |
| | −1 −1 1 1 −1 1 −1 −1 −1 1 1 −1 1 1 −1 1 −1 1 1 −1 1 1 −1 −1 1 −1 −1 1 −1 1 −1 |
| | −1 1 1 1 −1 −1 −1 −1 −1 1 1 −1 −1 1 1 1 −1 −1 1 1 1 −1 1 −1 −1 1 −1 1 −1 1 1 −1 |
| | 1 −1 1 1 1 −1 −1 1 1 1 −1 −1 1 1 1 1 1 −1 −1 −1 1 1 −1 −1 1 1 −1 1 1 −1 −1 1 −1 1 |
| | −1 1 1 1 −1 1 −1 −1 1 −1 −1 1 −1 1 1 1 −1 −1 −1 −1 −1 −1 −1 1 1 −1 1 1 −1 −1 −1 |
| | 1 −1 1 −1 1 1 −1 1 1 −1 −1 1 1 −1 1 −1 −1 1 −1 1 −1 1 1 1 1 −1 1 −1 −1 −1 −1 −1 |
| | 1 −1 1 1 1 −1 −1 −1 1 −1 1 −1 −1 −1 1 −1 −1 −1 −1 1 1 1 1 1 1 −1 1 −1 1 −1 1 1 |
| | −1 −1 −1 1 1 1 1 −1 1 1 −1 1 1 1 1 1 1 1 −1 1 −1 −1 −1 1 −1 1 1 −1 −1 1 1 −1 −1 |
| | −1 −1 −1 1 −1 −1 −1 1 1 −1 −1 −1 1 −1 −1 1 1 −1 −1 1 −1 1 1 1 −1 1 −1 −1 1 1 1 |
| | 1 −1 −1 1 −1 −1 1 1 1 −1 −1 1 −1 1 −1 −1 1 1 1 1 1 −1 −1 1 1 −1 −1 1 −1 −1 1 −1 |
| | 1 −1 1 1 1 1 1 1 −1 −1 1 1 −1 1 1 1 −1 −1 1 −1 1 −1 1 1 −1 1 −1 −1 1 1 −1 1 −1 1 |
| | 1 1 −1 −1 −1 −1 1 −1 1 1 −1 1 −1 −1 1 −1 −1 −1 −1 −1 −1 −1 1 1 −1 −1 −1 −1 −1 |
| | 1 1 1 1 1 −1 −1 −1 1 −1 1 −1 1 −1 −1 −1 1 1 1 −1 −1 1 1 −1 1 1 1 1 1 1 −1 −1 −1 |
| | −1 1 1 −1 1 −1 1 −1 1 1 −1 −1 1 −1 1 1 −1 −1 −1 1 1 −1 −1 1 1 −1 −1 1 −1 −1 −1 |
| | 1 1 −1 −1 1 −1 1 −1 −1 1 −1 1 −1 1 1 1 −1 −1 1 −1 1 1 −1 −1 −1 −1 −1 −1 −1 −1 1 |
| | 1 −1 −1 1 1 −1 1 −1 1 −1 1 1 1 1 1 −1 −1 1 1 −1 1 −1 −1 −1 −1 −1 −1 −1 −1 −1 −1 |
| | 1 1 −1 1 −1 1 −1 −1 −1 −1 −1 −1 −1 −1 1 1 1 1 1 1 1 1 1 1 1 −1 −1 1 1 −1 1 −1 1 |
| | −1 −1 −1 1 1 −1 −1 1 1 −1 1 −1 −1 −1 1 1 −1 −1 1 −1 1 1 −1 1 −1 −1 1 1 1 −1 −1 |
| | 1 −1 1 1 −1 1 1 −1 −1 1 −1 1 1 −1 1 1 1 1 1 −1 −1 1 1 1 −1 −1 −1 1 −1 1 −1 1 1 1 |
| | −1 1 −1 1 1 −1 −1 −1 1 1 1 −1 −1 1 1 1 −1 1 1 −1 1 −1 −1 1 1 1 1 1 1 −1 −1 1 1 1 |
| | −1 1 1 1 −1 −1 −1 −1 1 −1 1 −1 −1 1 −1 1 −1 −1 −1 1 −1 1 1 1 1 −1 1 1 −1 −1 1 1 |
| | −1 −1 −1 1 1 1 −1 1 −1 −1 1 1 1 1 1 −1 1 −1 1 −1 1 1 1 −1 −1 1 −1 −1 1 −1 −1 1 1 |
| | −1 −1 1 −1 −1 −1 1 −1 −1 −1 1 1 −1 −1 −1 −1 −1 −1 1 −1 1 −1 1 1 1 −1 −1 1 1 1 1 |
| | −1 1 1 −1 −1 1 −1 1 −1 −1 −1 1 −1 −1 −1 1 1 1 1 −1 −1 1 −1 −1 −1 −1 1 −1 1 1 1 |
| | 1 1 1 −1 1 1 −1 −1 −1 −1 −1 1 1 1 −1 −1 −1 −1 1 1 1 1 1 −1 1 −1 −1 −1 −1 1 −1 1 |
| | 1 −1 1 −1 1 1 −1 −1 1 1 −1 −1 1 1 −1 1 1 −1 1 1 −1 1 1 −1 1 1 1 1 1 1 −1 −1 1 −1 |
| | 1 1 1 −1 −1 1 1 1 −1 1 1 1 1 −1 −1 −1 −1 1 1 −1 1 1 1 −1 1 −1 1 −1 1 1 1 −1 1 1 |
| | −1 −1 −1 1 −1 1 −1 −1 1 −1 1 −1 1 −1 1 −1 −1 −1 1 1 1 1 −1 1 1 1 −1 1 1 −1 1 −1 |
| | 1 1 −1 1 −1 −1 −1 1 1 1 1 −1 −1 −1 1 −1 −1 1 1 1 1 −1 −1 −1 1 1 1 −1 1 −1 1 −1 1 |
| | 1 −1 1 1 1 1 −1 1 1 1 −1 1 −1 1 1 −1 −1 1 1 1 1 1 1 1 1 −1 −1 −1 −1 1 1 1 1 −1 1 1 |
| | −1 1 −1 1 1 1 −1 −1 −1 1 1 −1 1 −1 1 1 −1 1 1 1 1 1 −1 1 1 1 1 1 1 −1 1 1 1 1 −1 |
| | −1 1 1 −1 1 1 1 1 −1 1 −1 −1 1 1 1 1 1 1 1 −1 1 1 −1 1 1 1 −1 −1 1 1 1 1 1 −1 1 −1 |
| | 1 1 1 1 1 1 1 1 −1 1 1 1 1 −1 1 1 1 −1 −1 −1 1 1 1 1 1 1 −1 1 −1 −1 −1 1 1 1 1 −1 1 |
| | −1 1 −1 1 −1 1 1 −1 −1 1 1 −1 1 −1 1 −1 −1 1 1 1 −1 1 −1 1 −1 −1 −1 1 1 −1 1 1 1 |
| | −1 −1 1 −1 −1 −1 1 1 1 −1 −1 −1 −1 1 1 −1 1 1 −1 −1 1 −1 −1 1 1 1 −1 −1 −1 −1 1 |
| | −1 1 −1 1 1 −1 1 1 1 −1 1 1 1 −1 −1 −1 −1 −1 −1 1 −1 1 −1 −1 1 1 −1 1 −1 1 1 −1 |
| | −1 −1 −1 1 −1 −1 1 −1 −1 −1 1 1 1 1 1 1 −1 −1 1 −1 −1 −1 1 −1 1 1 −1 1 1 −1 −1 |
| | 1 1 1 1 −1 −1 −1 1 1 −1 −1 1 −1 −1 1 1 1 1 1 −1 −1 −1 −1 −1 −1 −1 −1 1 1 1 −1 1 |
| | 1 1 −1 −1 1 1 1 −1 −1 −1 1 1 1 −1 1 −1 −1 −1 1 1 1 −1 1 1 −1 −1 −1 −1 −1 −1 −1 |
| | 1 −1 1 −1 1 1 −1 −1 −1 1 −1 −1 1 −1 −1 1 1 1 −1 −1 −1 1 1 −1 1 1 −1 1 −1 −1 1 |
| | −1 1 −1 1 −1 1 1 −1 −1 1 −1 −1 1 −1 −1 1 −1 1 −1 1 1 −1 1 1 1 1 1 1 1 1 1 −1 −1 1 |
| | −1 −1 1 −1 −1 1 −1 −1 −1 1 1 1 −1 1 1 −1 1 −1 −1 −1 1 1 1 −1 −1 −1 −1 −1 1 −1 1 |
| | −1 1 −1 1 1 −1 −1 −1 −1 −1 1 1 1 1 −1 −1 −1 −1 −1 1 1 −1 −1 −1 1 1 −1 1 −1 1 1 |
| | 1 1 1 1 −1 −1 −1 1 −1 1 −1 −1 −1 −1 −1 −1 −1 1 −1 1 1 −1 1 −1 1 −1 −1 −1 1 −1 1 |
| | −1 1 −1 −1 −1 −1 1 1 −1 1 −1 1 −1 −1 1 −1 −1 −1 1 1 1 1 −1 1 −1 −1 −1 1 −1 −1 |
| | −1 −1 −1 −1 1 1 −1 1 1 1 1 −1 1 1 1 1 1 −1 1 −1 1 −1 1 −1 1 −1 −1 −1 1 −1 1 1 −1 |
| | −1 −1 1 −1 −1 1 1 −1 1 1 −1 1 −1 −1 −1 1 1 −1 −1 −1 −1 1 1 1 −1 −1 −1 −1 1 −1 1 |
| | 1 1 1 −1 −1 −1 1 −1 −1 1 −1 1 1 −1 1 1 1 1 −1 −1 −1 1 −1 −1 −1 −1 1 1 1 −1 1 1 |
| | −1 −1 1 1 −1 −1 1 1 1 1 1 −1 −1 −1 −1 1 −1 −1 −1 −1 −1 1 −1 −1 1 −1 1 1 1 −1 −1 |
| | 1 −1 −1 −1 1 −1 1 −1 −1 1 1 1 1 1 1 −1 1 1 1 1 1 −1 1 1 1 −1 1 1 −1 −1 −1 1 1 1 |
| | −1 −1 −1 1 1 −1 −1 −1 −1 1 1 −1 −1 −1 −1 1 −1 −1 1 −1 1 −1 1 1 −1 −1 1 1 1 −1 |
| | −1 1 1 −1 −1 1 −1 1 −1 −1 1 1 1 −1 1 −1 −1 −1 −1 −1 −1 −1 −1 1 −1 1 1 1 −1 −1 1 |
| | 1 −1 1 1 1 −1 1 1 −1 1 1 −1 1 −1 −1 −1 1 −1 −1 −1 −1 1 −1 1 1 1 −1 1 1 −1 −1 −1 |
| | −1 −1 1 −1 1 −1 −1 1 1 1 1 −1 1 −1 1 −1 −1 1 1 1 1 −1 −1 1 1 −1 1 1 −1 1 −1 1 1 1 |
| | 1 1 −1 1 −1 −1 −1 −1 −1 −1 1 1 1 −1 −1 1 −1 −1 1 −1 −1 −1 1 −1 −1 −1 1 −1 −1 |
| | −1 −1 1 1 −1 1 1 1 1 −1 −1 1 1 1 −1 1 1 −1 −1 −1 −1 1 −1 −1 1 1 −1 −1 1 −1 −1 1 |
| | 1 −1 −1 1 −1 1 −1 1 −1 1 1 1 1 1 −1 1 1 1 −1 −1 1 −1 −1 1 −1 1 1 1 −1 1 −1 −1 −1 |
| | 1 1 1 1 1 1 −1 1 1 −1 −1 1 −1 −1 1 −1 −1 −1 −1 1 −1 −1 −1 −1 1 −1 1 −1 −1 −1 1 |
| | −1 −1 1 −1 1 1 −1 −1 1 1 1 1 1 −1 1 1 −1 1 1 −1 1 −1 1 −1 1 −1 1 1 −1 1 1 1 −1 −1 |
| | 1 1 −1 1 1 −1 −1 1 1 1 −1 1 −1 −1 −1 1 1 −1 −1 1 1 1 1 −1 −1 1 −1 1 −1 1 1 1 −1 |
| | −1 −1 −1 1 1 1 1 −1 −1 1 −1 1 1 −1 1 1 1 −1 1 −1 −1 −1 −1 1 −1 1 −1 −1 1 −1 −1 |
| | −1 −1 −1 −1 1 1 1 −1 1 1 −1 −1 −1 1 −1 −1 −1 −1 1 1 −1 −1 1 1 1 1 1 1 1 −1 −1 |
| | −1 −1 1 −1 1 1 −1 −1 −1 −1 1 1 1 −1 −1 1 −1 1 −1 −1 −1 1 1 1 −1 1 −1 1 −1 −1 1 |
| | −1 1 −1 −1 1 −1 −1 1 −1 1 −1 −1 −1 −1 1 −1 1 −1 1 −1 −1 −1 1 −1 1 −1 −1 −1 −1 |
| | −1 1 −1 1 −1 −1 −1 −1 1 1 1 1 1 1 1 1 −1 1 1 −1 1 −1 1 −1 −1 −1 −1 1 1 −1 −1 −1 |
| | 1 −1 1 −1 −1 −1 1 1 −1 −1 −1 −1 −1 1 1 −1 1 1 −1 1 1 1 −1 −1 −1 −1 1 1 −1 −1 −1 |
| | −1 −1 −1 −1 1 1 −1 −1 1 −1 −1 1 −1 −1 1 1 1 −1 1 −1 1 1 1 −1 1 −1 −1 −1 1 −1 1 |
| | 1 1 −1 1 1 1 1 −1 −1 1 1 1 1 1 1 −1 1 1 −1 1 1 −1 −1 −1 1 −1 −1 1 1 1 1 1 −1 −1 1 |
| | −1 −1 −1 1 1 1 1 −1 −1 −1 −1 −1 −1 1 −1 −1 1 −1 1 −1 −1 −1 −1 −1 −1 1 −1 −1 1 |
| | −1 −1 −1 −1 −1 1 1 −1 1 1 −1 −1 1 1 −1 1 1 −1 1 −1 −1 1 1 1 −1 1 1 −1 1 −1 1 1 1 |
| | 1 −1 −1 1 −1 1 1 −1 −1 1 1 −1 −1 1 −1 −1 1 1 1 −1 1 −1 −1 1 1 −1 −1 1 −1 −1 −1 |
| | −1 −1 −1 −1 −1 −1 −1 −1 1 −1 1 1 −1 −1 −1 1 −1 1 1 1 −1 −1 −1 −1 1 1 −1 1 −1 |
| | −1 −1 1 1 1 1 1 −1 −1 1 1 1 1 1 −1 1 1 1 1 1 −1 −1 1 1 −1 −1 −1 −1 −1 1 1 −1 −1 1 |
| | −1 1 −1 −1 −1 −1 1 −1 −1 −1 1 −1 1 1 1 −1 −1 −1 1 1 1 −1 −1 1 −1 −1 −1 1 −1 −1 |
| | −1 −1 1 −1 −1 1 1 −1 −1 −1 −1 −1 1 −1 1 −1 1 1 1 1 −1 1 1 −1 −1 −1 1 −1 −1 1 −1 |
| | 1 1 1 1 1 1 −1 1 −1 −1 −1 −1 1 1 1 1 −1 −1 1 1 1 1 −1 −1 −1 1 −1 −1 −1 1 1 1 1 1 |
| | −1 1 −1 1 1 −1 1 1 1 −1 −1 −1 1 −1 1 −1 1 −1 1 −1 1 1 −1 1 −1 1 −1 −1 −1 −1 −1 |
| | 1 −1 −1 1 −1 −1 1 1 −1 1 −1 −1 −1 1 1 1 −1 1 −1 −1 −1 −1 1 1 −1 −1 −1 −1 −1 1 |
| | −1 1 1 1 1 1 1 −1 1 1 1 1 −1 1 −1 1 −1 −1 1 −1 1 1 −1 1 −1 1 −1 −1 1 1 −1 1 1 −1 −1 |
| | −1 1 −1 −1 −1 1 1 1 −1 1 −1 1 1 −1 1 −1 −1 1 −1 1 1 −1 −1 1 −1 −1 1 1 1 1 −1 −1 |
| | −1 −1 1 1 −1 −1 1 1 −1 −1 1 1 −1 −1 1 −1 1 −1 1 1 1 1 1 −1 −1 −1 1 −1 1 1 1 −1 |
| | −1 1 −1 1 1 1 −1 −1 −1 1 1 −1 −1 −1 1 1 1 −1 1 1 −1 1 1 −1 −1 1 −1 −1 −1 −1 1 |
| | −1 1 −1 1 1 1 −1 1 1 1 1 −1 1 1 1 1 −1 −1 1 −1 −1 1 1 −1 −1 −1 1 1 −1 −1 −1 −1 1 |
| | −1 −1 −1 −1 1 −1 −1 −1 −1 −1 −1 1 −1 1 1 1 −1 1 1 1 −1 −1 −1 1 1 −1 −1 |
| | −1 −1 1 1 −1 1 1 −1 1 1 −1 −1 −1 −1 1 −1 1 −1 1 −1 1 1 1 −1 −1 −1 1 −1 1 1 −1 |
| | −1 1 1 1 −1 −1 −1 1 −1 −1 −1 1 1 −1 1 1 −1 −1 1 1 1 1 1 −1 −1 1 −1 −1 1 1 −1 |
| | −1 −1 −1 1 −1 1 1 −1 −1 1 −1 1 1 −1 1 −1 1 1 1 1 1 1 1 −1 −1 1 1 −1 −1 −1 1 −1 1 |
| | 1 1 1 1 −1 −1 −1 1 1 1 1 1 1 1 1 −1 −1 1 −1 1 1 −1 −1 −1 1 −1 −1 −1 1 −1 1 −1 1 1 |
| | −1 1 −1 −1 −1 1 −1 1 1 −1 1 1 1 −1 1 1 −1 −1 −1 −1 1 1 −1 1 1 1 1 1 −1 1 1 −1 1 1 |
| | 1 1 −1 1 1 −1 −1 1 −1 −1 −1 −1 −1 −1 1 −1 −1 −1 1 −1 −1 1 −1 −1 1 1 −1 −1 −1 |
| | −1 −1 −1 −1 1 −1 −1 −1 1 1 1 1 −1 1 1 −1 −1 1 1 1 −1 −1 1 −1 −1 −1 1 1 −1 −1 −1 |
| | −1 1 −1 1 −1 −1 1 1 1 −1 −1 1 −1 −1 1 −1 1 −1 1 −1 1 1 1 −1 1 −1 1 −1 −1 −1 −1 |
| | −1 −1 1 −1 1 1 −1 −1 1 1 −1 1 −1 −1 −1 −1 1 −1 −1 −1 1 1 1 1 1 1 1 −1 1 −1 1 1 1 |
| | −1 −1 1 1 −1 −1 −1 1 −1 −1 1 1 1 −1 1 −1 −1 −1 1 −1 −1 −1 1 −1 −1 1 −1 1 1 1 −1 |
| | 1 1 −1 −1 1 −1 −1 1 1 −1 −1 −1 −1 1 −1 −1 1 1 1 −1 1 −1 1 −1 1 −1 1 1 1 −1 1 1 1 |
| | −1 −1 1 1 −1 −1 −1 −1 −1 −1 1 −1 −1 −1 1 1 −1 1 −1 1 −1 1 −1 1 −1 1 1 1 −1 −1 1 |
| | 1 −1 1 −1 1 −1 1 −1 1 1 1 1 1 1 1 1 1 1 1 1 −1 1 1 1 −1 −1 1 1 −1 1 −1 −1 −1 1 −1 |
| | −1 −1 1 1 −1 1 −1 −1 −1 1 −1 −1 1 1 1 −1 −1 1 −1 −1 −1 −1 1 −1 −1 1 1 1 −1 −1 |
| | −1 1 −1 −1 1 1 1 −1 −1 −1 −1 −1 −1 1 −1 −1 −1 −1 1 −1 1 1 −1 −1 1 1 1 1 −1 −1 1 |
| | 1 1 −1 1 −1 −1 −1 −1 1 −1 −1 −1 −1 1 1 1 −1 −1 1 −1 −1 −1 −1 −1 −1 −1 1 −1 −1 |
| | −1 −1 1 1 1 1 −1 1 −1 1 1 −1 −1 1 −1 −1 1 1 −1 1 −1 −1 1 1 1 1 1 −1 −1 −1 1 −1 |
| | −1 −1 1 −1 1 1 1 1 1 −1 −1 1 −1 −1 −1 −1 −1 −1 1 1 −1 −1 1 1 1 1 −1 1 1 −1 1 1 −1 |
| | 1 1 1 −1 1 1 −1 1 −1 −1 1 −1 1 1 1 −1 1 −1 1 −1 1 1 −1 −1 1 1 1 1 −1 1 1 1 1 1 −1 |
| | −1 −1 1 −1 −1 1 1 −1 1 −1 −1 1 −1 1 1 1 1 1 −1 1 1 −1 1 −1 1 1 −1 −1 −1 −1 −1 |
| | −1 −1 1 1 1 −1 1 −1 1 −1 −1 −1 −1 1 −1 1 −1 −1 −1 −1 −1 −1 1 1 −1 1 −1 1 1 −1 |
| | −1 −1 1 1 −1 −1 −1 1 −1 −1 −1 1 −1 −1 −1 1 1 1 −1 −1 −1 1 1 1 −1 −1 −1 −1 −1 |
| | −1 −1 1 −1 −1 1 1 1 1 −1 1 1 1 1 −1 −1 −1 −1 −1 1 −1 1 −1 −1 −1 1 1 1 1 −1 −1 1 |
| | 1 −1 −1 −1 −1 1 1 1 −1 1 −1 −1 1 1 −1 1 1 −1 −1 1 1 −1 −1 1 −1 1 1 1 1 1 −1 −1 |
| | −1 −1 1 1 1 −1 −1 1 1 1 −1 −1 1 −1 1 1 1 1 1 −1 1 −1 −1 1 −1 −1 −1 −1 −1 1 −1 1 |
| | 1 1 1 −1 −1 1 1 −1 −1 −1 1 1 1 1 1 −1 −1 −1 −1 1 1 −1 −1 −1 1 −1 −1 −1 −1 −1 −1 |
| | −1 −1 −1 1 −1 1 −1 −1 −1 −1 −1 1 1 1 −1 −1 1 1 1 1 −1 1 −1 −1 −1 1 1 −1 −1 −1 1 |
| | 1 1 1 1 1 −1 −1 −1 −1 −1 −1 −1 1 1 1 1 1 −1 1 1 1 −1 −1 −1 −1 −1 1 1 −1 1 1 1 1 1 |
| | 1 1 1 −1 −1 −1 1 1 1 1 −1 1 1 1 1 1 1 −1 −1 1 1 1 1 1 1 1 1 1 −1 −1 −1 −1 −1 1 1 1 |
| | 1 −1 1 −1 −1 −1 −1 −1 −1 −1 1 1 −1 1 −1 −1 −1 −1 −1 1 1 −1 −1 1 1 −1 −1 −1 1 |
| | −1 −1 −1 1 1 −1 −1 1 −1 −1 −1 −1 1 1 −1 −1 1 −1 1 1 1 −1 −1 −1 −1 1 −1 −1 1 −1 |
| | 1 1 1 1 −1 1 −1 1 1 1 −1 −1 −1 1 −1 −1 1 −1 −1 −1 −1 1 −1 1 −1 −1 1 1 −1 −1 −1 |
| | 1 1 1 1 −1 −1 −1 −1 1 −1 1 −1 1 −1 −1 1 1 −1 1 1 1 −1 −1 1 1 1 −1 1 −1 1 1 −1 1 1 |
| | −1 1 −1 −1 −1 −1 −1 −1 −1 1 −1 −1 1 −1 1 1 −1 −1 −1 1 1 1 −1 1 1 1 1 1 −1 1 −1 |
| | −1 −1 1 −1 −1 1 −1 −1 −1 −1 −1 −1 1 −1 1 −1 1 −1 1 −1 −1 −1 −1 1 1 1 1 −1 1 1 1 |
| | 1 −1 1 −1 −1 −1 −1 1 1 −1 1 −1 −1 −1 −1 1 1 1 −1 1 −1 1 −1 1 −1 −1 1 1 −1 −1 −1 |
| | 1 −1 1 1 −1 1 1 −1 1 1 1 1 −1 1 −1 −1 −1 1 1 1 −1 −1 1 −1 −1 1 1 −1 −1 1 1 1 −1 1 |
| | 1 −1 1 1 −1 1 1 −1 −1 1 1 1 −1 −1 −1 −1 −1 −1 −1 −1 −1 −1 1 −1 −1 1 −1 −1 1 −1 |
| | −1 1 −1 1 1 1 1 −1 −1 −1 1 1 −1 1 −1 −1 −1 −1 1 −1 1 −1 1 1 −1 −1 1 1 −1 −1 −1 |
| | 1 −1 1 −1 1 1 1 1 1 −1 1 −1 1 −1 −1 −1 1 −1 1 1 1 −1 −1 1 1 1 1 1 1 1 −1 1 −1 −1 |
| | 1 1 −1 1 −1 1 −1 1 −1 −1 1 1 1 −1 −1 1 1 −1 1 −1 −1 1 1 −1 −1 1 −1 1 −1 −1 −1 1 |
| | 1 −1 −1 1 −1 −1 1 −1 1 1 1 1 1 −1 −1 1 −1 1 1 −1 1 −1 1 −1 1 1 1 −1 −1 −1 −1 −1 |
| | 1 1 1 1 1 1 −1 −1 1 1 −1 −1 1 1 −1 1 −1 −1 1 1 1 −1 1 −1 −1 1 −1 −1 −1 1 1 1 −1 |
| | −1 1 −1 1 1 1 −1 1 −1 1 1 1 1 −1 1 −1 1 1 −1 −1 −1 −1 −1 1 −1 1 1 −1 1 1 −1 −1 |
| | −1 1 1 1 1 1 −1 1 −1 −1 1 −1 1 −1 −1 −1 −1 1 1 1 −1 1 1 1 −1 1 1 1 1 1 1 −1 1 −1 |
| | 1 1 −1 1 −1 1 −1 −1 1 −1 −1 1 1 1 1 −1 1 1 −1 1 −1 −1 1 1 −1 1 1 1 1 1 1 1 −1 −1 |
| | −1 −1 −1 −1 1 1 1 1 −1 −1 −1 1 −1 1 1 1 1 −1 1 −1 −1 −1 1 −1 1 −1 −1 −1 1 −1 1 |
| | −1 −1 1 −1 −1 1 1 −1 −1 −1 1 −1 −1 −1 −1 1 −1 −1 −1 1 −1 −1 1 1 −1 1 1 1 1 −1 |
| | −1 1 −1 1 −1 1 −1 1 −1 −1 1 1 1 1 −1 1 1 1 −1 −1 −1 −1 1 1 1 −1 −1 −1 1 1 −1 1 |
| | −1 −1 1 −1 1 −1 −1 1 1 1 1 −1 −1 −1 1 −1 1 −1 1 1 −1 −1 1 −1 −1 −1 −1 −1 1 1 −1 |
| | −1 1 −1 −1 −1 −1 −1 1 −1 −1 −1 1 1 1 −1 −1 1 1 1 1 1 1 −1 −1 1 −1 1 −1 1 −1 −1 |
| | −1 −1 1 −1 −1 1 −1 −1 1 −1 1 1 −1 1 −1 −1 1 −1 1 −1 −1 −1 1 1 1 1 1 −1 1 1 1 1 |
| | −1 −1 −1 1 −1 1 −1 −1 1 −1 −1 −1 1 −1 −1 1 −1 −1 −1 1 −1 −1 1 1 −1 −1 1 1 1 1 1 |
| | 1 −1 −1 −1 −1 1 −1 −1 1 −1 −1 1 1 1 1 −1 −1 1 −1 1 1 1 1 1 1 1 −1 −1 −1 1 −1 −1 |
| | 1 −1 −1 1 −1 1 −1 −1 1 −1 1 −1 −1 1 1 −1 1 −1 −1 1 −1 −1 1 1 1 −1 1 1 1 1 1 1 −1 |
| | −1 −1 1 1 1 −1 −1 1 1 −1 −1 1 1 1 −1 −1 −1 −1 1 −1 −1 −1 1 1 1 −1 1 1 1 1 −1 −1 |
| | 1 −1 1 1 1 −1 1 1 1 1 1 −1 1 1 −1 −1 1 1 1 1 −1 1 −1 1 1 1 1 1 −1 1 1 −1 −1 −1 1 1 |
| | 1 1 −1 −1 1 −1 1 −1 −1 1 1 −1 1 1 −1 1 −1 1 −1 1 1 1 1 −1 −1 −1 1 −1 1 1 −1 1 −1 |
| | 1 1 1 −1 1 1 1 1 1 1 1 1 −1 1 −1 1 1 −1 −1 −1 1 −1 1 −1 −1 −1 −1 1 −1 −1 1 1 −1 1 |
| | −1 −1 −1 −1 1 1 −1 −1 1 −1 −1 1 1 −1 1 1 −1 1 1 −1 −1 1 −1 1 −1 −1 1 1 −1 −1 1 |
| | −1 1 1 −1 −1 1 −1 1 −1 1 1 −1 −1 1 −1 1 −1 −1 −1 −1 −1 −1 −1 −1 −1 1 1 1 −1 −1 |
| | 1 1 −1 1 −1 1 1 1 −1 1 −1 −1 1 1 −1 1 −1 −1 −1 1 −1 1 −1 1 1 1 −1 −1 −1 1 1 1 1 |
| | −1 1 −1 1 1 1 −1 1 −1 1 −1 1 −1 −1 −1 1 −1 −1 1 −1 −1 1 −1 −1 −1 −1 1 1 −1 −1 |
| | −1 −1 1 1 −1 1 −1 −1 1 1 1 1 −1 −1 −1 −1 −1 1 −1 −1 −1 −1 −1 −1 −1 1 1 1 −1 −1 |
| | −1 1 −1 1 1 −1 1 1 1 1 1 1 −1 1 1 −1 1 −1 −1 −1 −1 −1 1 −1 1 −1 1 −1 −1 1 −1 −1 |
| | 1 1 −1 1 −1 1 −1 1 1 −1 1 1 −1 1 −1 1 −1 −1 −1 1 1 1 −1 1 1 1 −1 −1 −1 1 1 −1 1 1 |
| | 1 1 −1 −1 −1 1 1 −1 −1 −1 −1 −1 1 −1 −1 1 1 1 −1 1 1 1 −1 1 1 −1 1 1 1 1 −1 −1 1 |
| | −1 −1 −1 1 −1 −1 1 −1 1 −1 1 −1 1 −1 1 −1 1 1 −1 −1 −1 1 −1 1 1 −1 −1 −1 −1 1 |
| | −1 1 −1 −1 −1 1 1 −1 1 −1 −1 −1 −1 −1 −1 1 −1 −1 −1 −1 −1 −1 1 1 1 1 1 1 −1 1 1 |
| | 1 −1 1 −1 1 −1 −1 −1 1 −1 −1 1 1 −1 1 −1 1 1 −1 1 −1 −1 1 1 1 1 −1 1 −1 −1 −1 |
| | −1 1 −1 −1 1 −1 1 1 −1 1 −1 1 1 −1 1 1 1 −1 1 −1 1 −1 −1 1 1 −1 −1 −1 −1 −1 1 1 |
| | 1 −1 1 −1 −1 1 −1 −1 1 1 1 1 1 1 1 −1 −1 1 −1 1 −1 −1 −1 −1 −1 1 −1 −1 −1 −1 −1 |
| | 1 −1 1 1 −1 1 −1 −1 −1 −1 −1 −1 1 1 −1 −1 −1 1 1 1 1 −1 1 −1 −1 1 1 −1 −1 1 1 |
| | −1 −1 −1 1 1 −1 −1 1 −1 1 −1 1 1 −1 1 1 −1 1 1 1 −1 −1 1 −1 1 1 1 1 −1 −1 1 −1 1 |
| | −1 −1 −1 1 −1 1 −1 1 1 −1 −1 −1 −1 −1 −1 1 1 1 1 1 −1 −1 1 1 −1 1 1 −1 −1 −1 1 |
| | 1 −1 −1 1 −1 −1 −1 1 1 1 −1 1 −1 −1 1 −1 1 1 1 1 −1 −1 1 1 1 −1 −1 1 −1 −1 1 1 1 |
| | −1 1 1 −1 1 1 1 1 1 −1 1 −1 1 1 1 −1 1 1 1 −1 1 1 1 −1 1 1 −1 −1 1 1 1 1 1 1 −1 1 |
| | −1 −1 1 1 1 1 −1 1 1 −1 −1 −1 −1 1 −1 1 1 1 −1 1 −1 −1 −1 −1 1 1 1 −1 −1 −1 1 |
| | −1 −1 1 −1 1 −1 −1 1 1 −1 −1 −1 −1 1 1 1 1 1 −1 −1 −1 −1 −1 1 −1 −1 1 −1 −1 −1 |
| | 1 −1 1 1 1 −1 1 −1 1 1 −1 1 −1 1 1 −1 1 −1 1 −1 1 1 −1 −1 −1 −1 1 1 1 1 −1 1 −1 |
| | −1 1 −1 −1 −1 1 −1 1 −1 −1 −1 1 1 1 −1 −1 −1 1 −1 1 −1 −1 1 1 −1 −1 1 1 1 1 −1 |
| | 1 −1 −1 1 1 1 −1 1 1 1 1 −1 1 −1 −1 1 −1 1 1 1 −1 −1 −1 1 −1 −1 −1 −1 −1 −1 1 |
| | −1 −1 1 1 −1 −1 −1 1 −1 1 −1 −1 1 1 1 −1 1 1 −1 −1 −1 1 1 −1 −1 −1 −1 −1 −1 −1 |
| | −1 1 −1 −1 −1 1 −1 1 1 −1 −1 −1 −1 −1 −1 1 −1 1 1 1 1 1 1 1 1 1 −1 1 1 −1 −1 −1 |
| | 1 −1 1 1 −1 1 −1 −1 1 1 −1 −1 −1 1 1 −1 1 −1 −1 1 1 1 −1 −1 −1 −1 1 1 1 −1 1 −1 |
| | 1 1 1 −1 −1 −1 −1 −1 −1 1 1 1 −1 −1 −1 −1 −1 1 1 1 −1 1 1 −1 1 −1 1 −1 1 1 −1 1 |
| | −1 −1 1 −1 −1 1 −1 −1 −1 1 −1 1 −1 1 −1 1 1 −1 1 −1 −1 −1 −1 −1 1 1 1 −1 1 1 1 |
| | 1 −1 1 1 −1 1 −1 −1 −1 1 −1 1 −1 −1 1 1 −1 1 1 1 1 −1 1 1 −1 1 1 −1 −1 1 1 −1 −1 |
| | −1 −1 1 1 −1 −1 1 −1 1 −1 1 −1 −1 1 1 1 −1 1 1 1 −1 −1 1 −1 1 −1 −1 1 −1 1 1 1 1 |
| | 1 1 1 1 −1 −1 1 1 1 1 −1 1 1 1 −1 1 −1 −1 1 −1 −1 −1 −1 1 1 −1 1 −1 −1 1 −1 1 1 |
| | −1 1 1 −1 −1 −1 −1 1 1 1 −1 1 1 −1 1 1 1 −1 1 −1 1 1 −1 1 1 1 1 −1 −1 1 1 −1 −1 1 |
| | 1 1 1 −1 −1 −1 −1 1 −1 −1 −1 1 −1 1 −1 1 −1 −1 1 −1 1 1 1 −1 −1 1 1 −1 −1 1 1 |
| | −1 −1 −1 −1 1 −1 −1 −1 1 1 −1 −1 1 1 |
| 12 | −1 −1 −1 −1 −1 −1 −1 −1 −1 −1 −1 −1 −1 1 −1 −1 −1 1 −1 −1 −1 −1 1 −1 1 −1 1 1 |
| | −1 1 1 1 1 1 1 1 −1 −1 −1 1 1 1 1 1 −1 1 1 1 −1 −1 −1 1 −1 1 −1 −1 −1 −1 1 −1 1 |
| | −1 1 1 1 −1 1 1 −1 −1 1 1 −1 1 1 −1 −1 −1 1 −1 1 1 1 1 −1 −1 −1 −1 −1 1 1 −1 −1 |
| | −1 1 1 −1 −1 1 −1 1 −1 −1 −1 1 1 1 1 −1 −1 −1 1 1 1 1 −1 −1 −1 1 −1 −1 1 −1 1 1 |
| | 1 −1 −1 −1 1 −1 −1 −1 −1 1 1 1 −1 −1 −1 −1 1 −1 1 −1 1 −1 −1 1 −1 −1 1 1 −1 1 1 |
| | −1 1 −1 −1 1 1 1 −1 −1 1 1 −1 −1 1 −1 1 −1 1 1 −1 −1 −1 −1 1 1 −1 −1 −1 1 1 −1 |
| | 1 −1 −1 1 1 1 −1 1 1 −1 −1 1 1 1 1 −1 −1 1 −1 −1 −1 1 −1 1 1 −1 −1 1 1 −1 −1 1 |
| | −1 −1 −1 1 −1 1 −1 −1 1 1 −1 −1 1 1 −1 1 −1 1 −1 1 1 1 1 −1 −1 −1 1 1 −1 −1 1 1 |
| | 1 −1 1 1 1 1 −1 1 1 −1 1 −1 −1 1 1 −1 −1 1 1 −1 −1 1 1 −1 −1 −1 1 1 −1 1 1 −1 −1 |
| | 1 −1 −1 −1 1 −1 1 1 1 1 1 1 1 1 1 −1 −1 1 −1 1 −1 1 −1 −1 −1 −1 −1 1 1 −1 1 1 1 |
| | −1 −1 1 1 1 −1 1 1 1 1 1 −1 1 −1 −1 1 −1 1 1 1 1 −1 −1 1 −1 −1 −1 −1 −1 −1 1 1 |
| | −1 −1 1 −1 1 1 −1 −1 −1 −1 1 1 1 −1 1 1 −1 −1 −1 −1 −1 −1 1 1 −1 1 −1 1 −1 −1 1 |
| | 1 1 −1 −1 −1 1 −1 1 −1 −1 1 1 1 −1 −1 1 1 1 1 1 −1 −1 1 1 1 −1 1 1 1 −1 −1 −1 1 1 |
| | 1 1 −1 1 −1 −1 −1 1 1 1 1 1 −1 −1 −1 −1 1 1 1 −1 1 1 1 1 −1 −1 1 1 1 1 −1 −1 1 −1 |
| | 1 1 1 −1 −1 −1 −1 −1 1 −1 1 1 −1 1 −1 1 −1 −1 1 −1 −1 1 1 1 −1 1 −1 −1 1 −1 1 1 |
| | −1 1 1 −1 −1 −1 1 −1 −1 1 −1 1 1 −1 1 −1 −1 −1 1 −1 −1 −1 −1 −1 −1 1 1 −1 1 −1 |
| | −1 1 −1 1 −1 −1 −1 −1 −1 −1 1 −1 1 1 1 −1 −1 −1 −1 1 1 1 1 −1 −1 −1 −1 1 1 −1 1 |
| | −1 −1 −1 −1 1 1 1 −1 −1 1 −1 −1 −1 −1 −1 −1 −1 −1 −1 −1 −1 1 1 1 −1 1 1 1 −1 |
| | −1 1 1 −1 1 −1 −1 −1 −1 −1 1 1 1 1 1 −1 1 −1 1 −1 1 1 1 −1 −1 −1 1 −1 1 −1 1 1 |
| | −1 1 1 −1 −1 1 1 −1 1 −1 −1 1 −1 −1 −1 −1 1 1 −1 −1 −1 −1 −1 1 −1 1 1 −1 −1 1 1 |
| | −1 1 −1 −1 −1 1 −1 −1 1 −1 1 −1 −1 1 1 1 −1 1 1 −1 1 −1 1 1 −1 1 −1 1 −1 1 1 −1 |
| | 1 −1 1 1 1 1 1 −1 −1 1 −1 1 −1 1 1 1 −1 −1 1 −1 1 −1 1 −1 −1 1 1 −1 1 −1 1 1 1 1 |
| | 1 1 −1 −1 −1 −1 −1 −1 1 1 1 −1 1 −1 1 1 −1 −1 1 1 1 −1 1 −1 −1 −1 1 −1 −1 1 −1 |
| | −1 1 −1 1 −1 −1 −1 1 1 1 −1 1 −1 −1 −1 −1 1 1 −1 1 1 −1 1 1 1 1 −1 1 1 −1 −1 −1 |
| | 1 1 −1 −1 1 1 1 1 −1 1 1 −1 1 1 1 −1 −1 1 1 −1 −1 −1 1 −1 1 −1 −1 1 1 −1 1 −1 1 |
| | −1 −1 1 1 −1 1 −1 −1 −1 1 1 −1 −1 −1 −1 −1 1 1 1 −1 −1 1 1 −1 −1 1 1 −1 −1 1 −1 |
| | 1 −1 −1 −1 −1 −1 1 1 1 1 −1 1 1 −1 −1 1 1 1 1 1 1 1 −1 1 1 1 −1 1 −1 1 1 −1 −1 −1 |
| | 1 −1 −1 −1 −1 1 −1 1 1 −1 1 −1 −1 −1 1 1 1 −1 −1 1 1 1 1 −1 −1 1 1 −1 1 1 1 1 −1 |
| | −1 −1 −1 1 −1 −1 1 1 1 −1 −1 −1 1 −1 −1 1 −1 1 −1 −1 −1 −1 1 −1 −1 −1 −1 1 −1 |
| | −1 −1 1 −1 1 1 1 −1 1 −1 1 −1 1 1 −1 1 1 1 −1 1 −1 1 1 −1 1 1 1 −1 1 1 −1 1 −1 −1 |
| | −1 1 −1 1 −1 1 −1 1 1 −1 −1 1 1 −1 1 −1 1 1 1 −1 1 −1 −1 1 −1 1 −1 −1 −1 1 1 −1 |
| | 1 1 −1 1 1 −1 1 1 1 −1 −1 1 −1 1 −1 −1 −1 1 1 −1 −1 −1 −1 1 −1 1 1 1 1 1 1 −1 1 |
| | −1 −1 1 1 1 1 −1 −1 −1 −1 −1 −1 1 −1 1 1 1 1 1 −1 −1 −1 −1 1 1 −1 1 1 1 −1 −1 |
| | −1 −1 1 −1 −1 −1 1 1 1 1 −1 1 1 −1 −1 −1 −1 1 1 −1 −1 1 −1 1 −1 −1 1 −1 1 1 −1 |
| | 1 −1 −1 1 −1 −1 −1 1 1 −1 −1 1 −1 1 −1 1 1 1 1 −1 −1 −1 −1 −1 −1 −1 −1 −1 1 −1 |
| | 1 −1 −1 −1 1 −1 1 1 −1 −1 −1 1 1 −1 −1 −1 1 −1 1 1 1 −1 −1 1 −1 1 −1 −1 1 −1 1 |
| | −1 1 1 −1 1 −1 −1 −1 −1 −1 −1 1 1 −1 −1 −1 1 1 1 1 1 −1 −1 1 −1 −1 1 −1 −1 −1 1 |
| | 1 −1 −1 −1 1 1 −1 −1 −1 1 1 −1 1 1 1 1 1 −1 1 1 1 −1 1 −1 −1 −1 −1 −1 1 −1 −1 |
| | −1 −1 1 −1 1 −1 −1 −1 −1 1 −1 −1 1 1 1 −1 1 1 1 −1 1 −1 −1 1 −1 1 1 1 −1 1 −1 1 |
| | 1 1 −1 −1 −1 1 −1 −1 1 1 1 1 −1 1 −1 −1 −1 −1 1 −1 1 −1 −1 1 −1 −1 −1 1 1 −1 1 |
| | −1 −1 1 1 −1 1 1 1 1 1 1 1 1 −1 1 1 −1 1 −1 1 −1 −1 1 1 −1 −1 1 −1 −1 −1 −1 −1 |
| | −1 −1 1 1 −1 −1 −1 −1 1 −1 1 −1 −1 1 1 −1 1 1 −1 −1 −1 −1 −1 −1 1 −1 1 1 −1 −1 |
| | 1 −1 1 1 −1 1 1 1 −1 −1 −1 1 −1 1 1 1 −1 −1 −1 1 1 −1 1 −1 −1 1 −1 −1 −1 1 −1 1 |
| | −1 1 1 −1 −1 1 1 −1 −1 1 1 1 −1 1 1 −1 −1 −1 1 −1 1 1 −1 −1 −1 −1 1 1 −1 1 1 1 1 |
| | 1 −1 −1 −1 1 −1 −1 1 −1 −1 −1 1 −1 1 1 1 −1 −1 1 1 −1 −1 −1 −1 1 1 −1 1 −1 1 −1 |
| | 1 1 −1 1 1 −1 1 1 −1 −1 −1 −1 1 1 −1 1 −1 −1 1 1 1 1 −1 1 −1 1 −1 1 1 1 1 1 −1 1 |
| | 1 −1 −1 1 1 1 −1 −1 1 1 1 −1 1 1 −1 −1 1 −1 −1 1 −1 1 −1 −1 −1 −1 −1 1 −1 −1 1 |
| | −1 −1 −1 −1 −1 1 −1 −1 −1 −1 −1 1 1 −1 1 1 −1 1 −1 1 −1 −1 −1 1 1 −1 −1 −1 1 |
| | −1 −1 1 −1 −1 1 1 1 1 −1 1 1 −1 1 −1 −1 −1 −1 −1 −1 −1 −1 −1 −1 1 −1 1 1 1 −1 1 |
| | 1 −1 1 −1 −1 1 −1 −1 1 1 −1 1 1 1 1 −1 −1 1 1 1 −1 1 1 −1 1 −1 −1 −1 −1 1 1 |
| | −1 −1 1 1 1 −1 1 −1 −1 1 −1 −1 −1 −1 1 −1 1 −1 −1 1 1 1 −1 1 −1 1 1 −1 −1 −1 −1 |
| | 1 −1 −1 1 −1 −1 1 1 1 −1 1 1 1 1 −1 −1 −1 −1 1 1 1 1 1 −1 1 −1 −1 1 1 1 −1 1 −1 |
| | −1 1 1 −1 1 −1 −1 −1 −1 −1 −1 −1 1 1 −1 1 1 −1 1 1 −1 −1 −1 1 −1 1 −1 −1 1 −1 1 |
| | 1 −1 −1 1 1 1 −1 1 1 1 1 −1 1 −1 −1 −1 −1 1 1 −1 −1 −1 −1 1 −1 −1 1 −1 1 |
| | −1 1 1 1 −1 1 1 1 1 1 1 1 −1 1 −1 −1 1 −1 1 −1 −1 1 −1 1 −1 −1 −1 −1 1 1 1 −1 −1 |
| | −1 1 −1 −1 1 1 −1 −1 −1 1 1 1 −1 −1 1 1 −1 1 1 −1 −1 1 1 1 1 −1 1 −1 −1 −1 1 −1 |
| | −1 1 1 1 1 −1 −1 1 −1 −1 1 −1 −1 1 −1 1 −1 1 1 1 1 −1 1 1 −1 −1 1 1 −1 −1 1 1 −1 |
| | 1 1 1 1 1 −1 1 −1 −1 −1 1 1 1 −1 −1 −1 −1 1 1 1 1 1 1 −1 −1 −1 −1 −1 1 −1 1 1 1 |
| | −1 −1 1 1 1 1 −1 −1 −1 −1 −1 1 −1 −1 1 −1 −1 1 1 −1 1 1 1 −1 −1 −1 −1 −1 1 −1 |
| | −1 −1 −1 1 1 −1 −1 −1 1 1 1 −1 −1 −1 −1 −1 1 −1 1 −1 1 1 −1 −1 1 −1 1 −1 1 −1 |
| | −1 −1 1 1 1 1 1 −1 1 1 −1 1 −1 −1 −1 1 1 −1 −1 1 1 −1 1 −1 −1 −1 −1 1 −1 1 1 −1 |
| | −1 −1 1 −1 −1 1 −1 −1 −1 −1 1 1 1 −1 1 −1 1 1 1 1 1 1 −1 1 1 −1 −1 1 −1 1 1 −1 |
| | −1 1 −1 −1 1 −1 −1 −1 1 −1 1 −1 −1 −1 −1 −1 −1 −1 −1 −1 1 −1 −1 1 −1 −1 −1 1 |
| | 1 1 −1 1 1 −1 −1 1 −1 1 −1 −1 1 1 1 −1 −1 −1 −1 1 1 −1 1 −1 1 1 −1 1 −1 −1 −1 |
| | −1 1 1 1 1 1 1 −1 1 1 −1 −1 −1 1 1 1 1 1 1 −1 −1 −1 1 1 1 −1 −1 −1 1 −1 −1 −1 −1 |
| | −1 −1 1 −1 1 1 −1 1 −1 −1 1 −1 1 1 1 1 1 1 1 −1 1 1 −1 −1 −1 −1 −1 1 1 −1 −1 −1 |
| | −1 −1 −1 −1 −1 1 1 −1 −1 1 −1 −1 −1 −1 −1 1 1 1 1 1 1 −1 −1 1 1 −1 1 1 −1 1 1 |
| | −1 1 −1 −1 −1 −1 −1 1 1 −1 −1 1 −1 −1 1 1 −1 1 −1 −1 1 1 1 1 1 −1 −1 1 1 −1 1 1 |
| | 1 −1 1 −1 −1 1 −1 −1 −1 1 −1 −1 1 1 1 1 1 1 1 −1 1 −1 −1 −1 1 1 −1 1 −1 −1 1 −1 |
| | 1 1 1 −1 −1 1 1 1 −1 1 −1 −1 1 1 1 −1 −1 −1 1 1 −1 −1 −1 −1 −1 1 −1 −1 −1 −1 −1 |
| | −1 −1 −1 1 −1 1 1 −1 1 1 1 1 −1 −1 −1 1 1 1 −1 −1 1 −1 −1 −1 1 1 −1 −1 1 1 −1 |
| | −1 1 −1 −1 1 −1 −1 1 1 1 1 1 −1 1 −1 −1 1 −1 −1 −1 1 1 1 1 1 −1 −1 1 1 1 1 −1 1 1 |
| | 1 1 −1 1 1 −1 −1 1 −1 1 −1 1 −1 1 1 1 1 −1 −1 1 −1 1 −1 1 −1 1 1 −1 −1 −1 −1 −1 |
| | 1 1 −1 1 1 −1 −1 1 1 −1 1 1 1 1 −1 1 1 −1 1 1 1 1 1 1 1 1 1 −1 1 −1 −1 1 1 −1 −1 |
| | −1 −1 1 1 −1 −1 1 1 −1 −1 −1 −1 1 1 1 −1 −1 1 1 −1 1 −1 1 −1 1 −1 −1 1 −1 1 1 1 |
| | 1 −1 1 −1 −1 −1 1 1 −1 −1 1 −1 1 1 −1 1 1 −1 1 −1 −1 −1 1 1 1 1 1 1 1 −1 −1 −1 |
| | −1 1 −1 1 −1 −1 −1 1 1 1 −1 −1 1 −1 −1 1 −1 1 −1 1 −1 1 −1 −1 −1 1 1 −1 1 −1 −1 |
| | −1 1 1 1 −1 1 −1 1 1 −1 1 −1 1 1 1 −1 −1 −1 −1 −1 1 1 −1 1 −1 −1 1 1 −1 −1 −1 1 |
| | 1 −1 −1 1 1 −1 −1 −1 1 −1 1 1 1 1 1 1 −1 −1 1 −1 1 −1 −1 1 −1 −1 1 1 1 1 −1 −1 |
| | −1 −1 1 1 1 −1 −1 −1 1 1 1 1 1 1 1 −1 1 1 −1 1 1 −1 −1 −1 −1 −1 −1 −1 1 1 1 1 1 1 |
| | −1 1 −1 1 −1 −1 −1 −1 1 1 1 −1 1 1 1 −1 1 −1 1 −1 −1 1 −1 −1 −1 1 −1 −1 −1 −1 1 |
| | 1 −1 −1 1 −1 1 1 1 1 −1 −1 −1 −1 1 −1 1 −1 1 1 1 1 −1 1 −1 1 −1 1 −1 1 −1 1 1 1 |
| | −1 −1 −1 −1 1 1 −1 −1 −1 −1 1 1 1 1 −1 −1 1 1 1 1 1 −1 −1 −1 −1 1 −1 −1 −1 1 −1 |
| | −1 1 −1 −1 −1 −1 −1 −1 1 −1 −1 1 1 1 1 −1 −1 −1 1 −1 1 1 1 1 −1 1 1 −1 −1 −1 −1 |
| | −1 −1 −1 −1 −1 1 1 −1 −1 −1 1 −1 −1 1 1 1 1 1 −1 −1 −1 1 1 1 −1 1 1 1 −1 1 1 −1 |
| | −1 −1 −1 1 −1 −1 1 1 1 1 1 −1 1 1 1 1 −1 1 1 1 1 1 −1 −1 1 1 −1 1 −1 −1 −1 1 1 1 |
| | 1 −1 −1 1 −1 1 1 −1 1 −1 −1 1 1 1 −1 1 −1 1 −1 1 −1 −1 1 −1 −1 −1 1 1 1 −1 −1 |
| | −1 −1 −1 −1 1 1 −1 −1 −1 −1 −1 1 1 −1 1 −1 1 −1 1 −1 1 1 1 1 −1 1 −1 −1 1 1 −1 |
| | −1 1 1 1 1 1 1 1 1 −1 1 1 1 −1 −1 1 1 1 1 1 −1 1 −1 1 1 1 −1 1 1 −1 1 1 −1 −1 −1 1 |
| | 1 −1 −1 −1 −1 1 1 1 −1 1 −1 1 −1 −1 1 1 −1 1 1 1 −1 1 −1 1 −1 −1 −1 1 −1 −1 −1 |
| | 1 −1 −1 −1 −1 −1 1 1 −1 −1 −1 −1 1 1 −1 −1 −1 −1 −1 −1 1 1 1 1 1 1 1 −1 −1 1 1 |
| | 1 −1 −1 1 −1 −1 1 −1 −1 1 1 −1 −1 1 −1 −1 1 −1 1 −1 1 1 −1 −1 −1 1 −1 1 −1 1 1 |
| | 1 1 −1 −1 1 1 −1 −1 1 1 −1 1 −1 −1 1 1 1 −1 −1 −1 −1 −1 −1 −1 1 1 −1 1 −1 1 1 1 |
| | 1 1 −1 1 −1 −1 1 1 −1 1 1 −1 1 −1 1 −1 1 1 1 1 1 1 −1 1 −1 1 −1 1 1 −1 1 −1 −1 −1 |
| | 1 1 −1 1 −1 1 −1 −1 1 −1 −1 −1 −1 1 −1 −1 1 −1 1 −1 −1 −1 1 −1 −1 −1 1 1 1 −1 |
| | −1 1 −1 1 −1 −1 1 1 −1 −1 1 −1 1 1 −1 −1 1 1 1 1 −1 1 1 1 −1 1 1 1 1 1 1 −1 1 1 |
| | −1 1 −1 −1 1 −1 1 −1 1 −1 1 −1 1 1 1 1 1 −1 −1 −1 −1 −1 −1 −1 1 −1 −1 −1 −1 −1 |
| | 1 −1 1 1 1 1 −1 −1 1 −1 1 1 −1 −1 1 −1 1 −1 −1 −1 1 −1 −1 1 −1 1 1 1 1 1 −1 1 1 1 |
| | −1 −1 1 −1 −1 1 1 1 −1 −1 1 1 −1 1 −1 −1 1 1 −1 1 −1 −1 1 1 −1 −1 1 −1 1 −1 1 |
| | −1 1 −1 −1 1 −1 1 −1 −1 1 −1 −1 1 −1 −1 1 −1 1 1 −1 1 1 −1 1 1 1 −1 1 −1 −1 1 1 |
| | 1 −1 1 1 1 1 1 1 −1 −1 −1 −1 1 1 1 1 −1 1 1 −1 1 −1 1 1 −1 −1 1 1 −1 −1 −1 −1 1 |
| | −1 −1 −1 −1 −1 −1 −1 1 −1 −1 1 −1 1 1 1 1 −1 1 1 1 −1 1 −1 1 −1 1 −1 −1 −1 1 −1 |
| | −1 −1 −1 1 −1 −1 1 1 1 1 −1 1 1 1 −1 −1 −1 1 1 −1 −1 −1 1 1 1 −1 1 1 −1 −1 −1 1 |
| | 1 −1 1 −1 1 1 −1 1 1 1 −1 −1 −1 −1 1 1 1 −1 1 −1 −1 1 −1 1 −1 1 1 1 1 1 −1 1 −1 1 |
| | −1 1 −1 −1 −1 −1 1 −1 −1 1 −1 −1 −1 1 −1 −1 −1 1 −1 1 −1 1 −1 −1 1 1 −1 −1 1 1 |
| | 1 −1 −1 1 1 −1 1 1 1 1 1 1 −1 −1 −1 1 −1 1 1 −1 1 1 1 −1 −1 1 −1 −1 1 −1 −1 −1 |
| | −1 −1 −1 −1 1 −1 1 −1 −1 1 −1 −1 1 −1 1 −1 −1 1 −1 1 1 1 −1 −1 −1 −1 1 −1 −1 1 |
| | −1 1 1 −1 1 1 1 −1 1 1 1 −1 −1 −1 1 −1 −1 1 −1 −1 1 −1 −1 1 −1 −1 −1 −1 1 −1 1 |
| | 1 1 1 1 −1 1 1 −1 1 −1 1 1 1 1 1 1 1 1 −1 −1 1 1 1 1 1 1 −1 1 −1 −1 −1 1 −1 1 1 −1 |
| | 1 −1 −1 1 1 −1 1 1 −1 −1 1 1 −1 −1 −1 1 1 1 −1 1 −1 1 −1 −1 −1 −1 −1 1 −1 −1 −1 |
| | 1 −1 −1 1 1 1 −1 −1 1 1 1 −1 −1 −1 −1 −1 −1 1 −1 1 −1 −1 1 1 1 1 −1 −1 1 −1 1 |
| | −1 −1 −1 −1 1 1 −1 1 −1 −1 −1 1 −1 1 1 1 1 1 −1 −1 1 1 1 1 1 −1 1 1 −1 1 1 1 −1 1 |
| | −1 1 −1 1 1 1 −1 1 1 1 −1 −1 1 1 1 −1 −1 −1 1 1 −1 1 1 −1 −1 −1 1 −1 −1 −1 1 1 1 |
| | 1 −1 −1 −1 −1 −1 1 1 1 1 −1 1 −1 1 −1 1 −1 −1 1 1 1 −1 1 −1 −1 −1 −1 −1 1 1 1 |
| | −1 −1 −1 1 1 −1 −1 1 1 −1 1 1 1 −1 −1 −1 1 1 1 −1 1 1 −1 1 1 1 1 1 −1 −1 1 1 1 −1 |
| | −1 −1 1 −1 1 1 1 1 1 −1 1 −1 1 1 −1 −1 −1 1 1 1 −1 −1 −1 1 1 1 −1 −1 1 1 1 −1 1 |
| | −1 1 −1 1 1 1 1 −1 1 1 1 1 1 1 1 1 1 1 −1 −1 −1 −1 −1 −1 −1 −1 1 −1 −1 1 1 1 −1 1 |
| | −1 −1 −1 1 1 1 1 −1 1 −1 −1 1 −1 1 1 −1 −1 −1 −1 −1 1 −1 −1 −1 1 1 −1 −1 1 −1 |
| | −1 1 1 1 −1 −1 −1 −1 −1 1 1 1 1 1 −1 −1 1 1 −1 −1 −1 1 −1 −1 1 −1 1 −1 1 1 −1 1 |
| | 1 1 −1 −1 1 1 1 1 −1 1 1 −1 −1 −1 1 −1 1 −1 1 −1 −1 1 −1 1 −1 1 −1 −1 −1 −1 1 |
| | −1 1 −1 −1 −1 1 −1 −1 −1 −1 −1 1 −1 1 −1 −1 1 −1 1 −1 −1 1 1 1 1 −1 1 −1 −1 1 1 |
| | 1 −1 −1 1 −1 1 −1 1 1 −1 −1 1 1 1 1 1 1 −1 1 1 1 −1 1 1 −1 1 −1 1 1 1 −1 −1 1 1 |
| | −1 1 −1 1 1 −1 −1 −1 −1 1 1 1 1 −1 1 −1 1 1 −1 −1 −1 −1 −1 1 −1 1 1 1 1 1 1 1 −1 |
| | −1 −1 −1 −1 1 1 −1 1 1 1 1 1 1 1 −1 1 1 1 1 −1 −1 1 −1 1 −1 −1 1 1 1 1 1 −1 −1 −1 |
| | −1 −1 1 −1 −1 −1 1 −1 1 −1 1 1 1 1 1 1 1 1 1 1 1 1 −1 −1 1 1 −1 −1 1 1 1 −1 −1 −1 |
| | −1 −1 1 −1 −1 1 1 1 1 1 1 −1 1 1 −1 1 1 1 1 −1 −1 1 1 −1 1 1 −1 −1 −1 −1 1 1 1 −1 |
| | −1 −1 −1 −1 1 1 −1 −1 1 −1 1 −1 1 −1 −1 1 −1 1 1 −1 −1 −1 1 1 1 −1 1 1 1 1 −1 1 |
| | −1 1 1 −1 1 −1 1 −1 −1 −1 −1 1 1 −1 1 1 1 −1 1 1 −1 1 1 1 −1 1 1 −1 −1 1 −1 −1 |
| | −1 1 1 −1 1 1 −1 −1 1 1 1 −1 1 1 −1 1 1 1 −1 −1 −1 −1 −1 −1 1 −1 −1 1 −1 1 −1 |
| | −1 1 −1 −1 −1 1 −1 1 1 −1 1 −1 1 −1 1 −1 −1 −1 −1 −1 1 −1 1 1 1 −1 1 −1 1 1 −1 |
| | 1 −1 −1 −1 1 −1 1 1 −1 −1 1 −1 1 −1 1 1 1 −1 1 −1 −1 1 1 −1 −1 −1 1 −1 1 −1 1 |
| | −1 1 −1 −1 1 1 −1 −1 −1 −1 1 −1 1 −1 1 −1 1 −1 −1 −1 −1 −1 −1 1 1 1 −1 1 1 −1 1 |
| | −1 1 −1 1 1 −1 −1 1 1 1 −1 −1 1 −1 −1 −1 1 −1 1 −1 1 −1 1 −1 1 −1 1 −1 1 1 −1 1 |
| | −1 −1 1 −1 1 −1 −1 1 1 −1 −1 −1 1 1 1 1 1 1 1 1 −1 1 −1 −1 −1 −1 −1 −1 1 1 1 1 |
| | −1 1 −1 −1 1 1 −1 1 −1 1 1 −1 −1 1 1 1 1 −1 −1 −1 1 −1 −1 −1 1 1 1 −1 1 −1 −1 1 |
| | 1 1 1 1 −1 1 −1 1 −1 −1 −1 1 −1 1 1 1 −1 1 1 −1 −1 1 −1 1 1 1 1 1 −1 1 −1 −1 −1 |
| | −1 −1 1 −1 1 1 −1 1 1 −1 −1 −1 −1 1 −1 1 1 −1 1 −1 1 1 1 1 −1 1 −1 1 1 −1 −1 1 1 |
| | −1 1 1 −1 1 1 1 −1 −1 −1 1 1 −1 1 1 1 1 −1 1 1 1 −1 1 1 −1 −1 1 1 1 −1 1 −1 1 1 1 |
| | −1 1 −1 −1 −1 1 1 −1 1 1 1 1 −1 −1 −1 1 −1 −1 −1 −1 −1 1 −1 −1 1 −1 1 1 −1 −1 |
| | −1 1 −1 −1 −1 1 −1 −1 1 −1 1 1 −1 −1 1 −1 −1 −1 1 −1 −1 −1 1 1 −1 −1 1 1 1 1 1 |
| | −1 1 −1 −1 −1 1 −1 −1 −1 −1 1 1 1 1 1 −1 −1 −1 1 1 −1 1 1 1 −1 1 1 1 −1 1 1 1 −1 |
| | 1 −1 −1 −1 1 1 1 −1 1 1 −1 1 −1 −1 1 1 1 1 1 1 1 1 1 1 −1 1 1 −1 −1 1 1 −1 1 −1 1 |
| | −1 −1 −1 1 1 1 1 −1 1 1 1 1 −1 −1 −1 −1 −1 −1 1 1 −1 1 1 −1 −1 −1 −1 −1 1 −1 −1 |
| | 1 −1 1 −1 1 −1 −1 −1 1 −1 −1 1 1 1 −1 1 −1 1 1 1 1 −1 −1 −1 1 −1 1 −1 1 −1 −1 |
| | −1 1 1 −1 −1 1 −1 −1 −1 −1 1 −1 1 1 −1 −1 1 −1 −1 −1 −1 1 −1 −1 −1 −1 −1 −1 1 |
| | −1 −1 −1 −1 1 1 1 1 −1 1 −1 −1 −1 −1 −1 1 1 −1 1 −1 −1 −1 −1 −1 −1 1 −1 1 −1 |
| | −1 −1 −1 1 1 1 1 1 −1 1 1 1 1 1 −1 1 1 −1 −1 −1 −1 1 −1 1 −1 1 1 −1 −1 −1 1 1 −1 |
| | −1 1 −1 −1 1 −1 −1 −1 −1 1 1 −1 1 1 −1 −1 −1 1 1 1 −1 1 −1 −1 1 −1 −1 1 1 1 −1 |
| | −1 1 −1 1 1 −1 1 −1 1 −1 1 1 1 −1 −1 1 −1 −1 1 1 −1 1 −1 1 −1 1 1 −1 −1 −1 −1 1 |
| | −1 1 −1 −1 −1 −1 −1 1 −1 1 −1 −1 −1 1 1 −1 1 −1 1 1 1 1 −1 1 1 −1 1 −1 1 −1 1 |
| | −1 1 −1 1 −1 −1 −1 −1 1 1 1 1 −1 1 1 1 −1 −1 1 −1 1 −1 1 1 1 1 1 1 −1 −1 1 1 −1 |
| | −1 −1 −1 1 −1 1 −1 −1 1 1 1 −1 −1 −1 1 −1 −1 −1 1 1 −1 1 1 −1 1 −1 1 1 1 −1 1 |
| | −1 1 −1 −1 1 1 1 −1 1 1 1 −1 −1 1 −1 1 1 −1 1 1 −1 −1 1 −1 −1 −1 −1 1 1 1 −1 −1 |
| | 1 1 1 −1 −1 1 1 −1 −1 −1 1 1 −1 −1 −1 −1 −1 −1 1 −1 −1 1 1 −1 −1 −1 −1 1 −1 −1 |
| | 1 1 −1 −1 1 −1 −1 −1 1 1 −1 −1 −1 −1 −1 −1 −1 1 −1 1 −1 1 −1 −1 −1 −1 1 1 −1 |
| | −1 −1 1 −1 −1 −1 −1 1 1 −1 1 −1 −1 1 −1 −1 1 −1 −1 1 1 −1 1 −1 −1 −1 −1 1 1 −1 |
| | 1 −1 1 1 1 −1 −1 −1 1 1 1 1 1 −1 −1 −1 1 −1 1 1 1 −1 1 1 1 1 1 −1 −1 −1 1 1 1 1 |
| | −1 1 1 1 −1 1 −1 −1 1 1 −1 1 1 1 −1 −1 1 1 −1 1 1 1 −1 −1 1 −1 1 1 1 −1 1 −1 1 −1 |
| | −1 −1 −1 1 −1 −1 −1 1 −1 −1 −1 1 −1 −1 1 1 −1 1 −1 1 −1 −1 −1 −1 −1 1 1 1 −1 1 |
| | 1 1 1 1 1 1 1 −1 −1 −1 −1 1 1 −1 −1 −1 1 −1 1 1 −1 1 −1 1 1 −1 −1 −1 1 1 −1 1 −1 |
| | −1 −1 −1 1 −1 −1 −1 −1 −1 1 −1 −1 −1 1 1 1 1 1 −1 1 −1 1 1 −1 1 1 1 1 −1 1 −1 |
| | −1 1 −1 −1 1 1 −1 1 −1 1 1 −1 1 −1 1 1 −1 1 −1 −1 1 1 1 1 −1 −1 1 1 −1 −1 −1 1 1 |
| | 1 1 −1 −1 1 1 1 −1 −1 −1 −1 1 1 1 −1 −1 1 −1 1 1 −1 −1 1 1 −1 −1 −1 1 −1 −1 −1 |
| | 1 1 −1 −1 −1 −1 1 1 −1 1 1 −1 −1 1 −1 1 1 1 −1 −1 −1 1 1 1 −1 −1 −1 −1 1 −1 −1 |
| | 1 1 −1 1 −1 −1 −1 1 −1 1 −1 −1 1 1 1 1 1 1 1 −1 −1 1 −1 −1 −1 −1 −1 1 −1 1 −1 1 |
| | −1 −1 1 1 1 1 1 1 −1 1 −1 1 1 1 −1 −1 −1 −1 1 −1 1 −1 −1 1 −1 1 1 1 1 1 −1 −1 −1 |
| | 1 −1 1 −1 −1 −1 1 −1 −1 1 1 −1 1 1 −1 −1 −1 1 1 −1 1 1 −1 1 −1 −1 −1 1 −1 −1 1 |
| | 1 −1 −1 −1 −1 −1 1 −1 1 −1 1 −1 1 −1 1 1 −1 −1 1 −1 1 1 −1 −1 −1 1 −1 1 1 1 −1 |
| | 1 −1 −1 1 1 1 1 −1 1 1 −1 −1 1 −1 −1 1 1 −1 −1 −1 1 1 −1 1 −1 1 −1 1 1 1 −1 1 −1 |
| | −1 −1 −1 −1 −1 1 −1 −1 1 −1 −1 1 −1 1 1 1 −1 1 −1 −1 −1 1 −1 1 1 1 −1 −1 −1 −1 |
| | −1 −1 1 1 1 1 −1 −1 1 −1 1 −1 1 1 −1 1 −1 1 1 −1 −1 1 −1 1 −1 −1 1 −1 −1 −1 −1 |
| | 1 1 1 1 −1 −1 1 −1 −1 1 1 1 1 −1 −1 1 1 1 1 −1 1 −1 −1 1 −1 −1 −1 −1 −1 1 1 −1 1 |
| | −1 1 1 −1 −1 1 −1 −1 1 −1 1 1 1 −1 −1 1 −1 −1 −1 1 1 1 1 1 1 1 1 1 −1 −1 −1 1 1 |
| | −1 −1 1 −1 −1 −1 1 −1 −1 1 −1 1 −1 1 −1 1 1 1 −1 1 −1 1 1 −1 −1 1 −1 −1 −1 1 1 |
| | 1 −1 1 −1 1 −1 1 1 −1 −1 −1 1 −1 −1 1 1 1 −1 −1 −1 −1 1 −1 1 1 −1 −1 −1 −1 1 −1 |
| | 1 1 1 −1 −1 1 −1 −1 1 −1 1 1 −1 −1 1 1 1 −1 1 1 1 −1 1 1 1 1 −1 −1 −1 1 −1 1 1 −1 |
| | −1 −1 1 −1 1 −1 −1 −1 1 1 1 1 1 1 −1 1 −1 −1 1 −1 −1 1 −1 1 1 −1 −1 −1 −1 1 −1 |
| | −1 −1 1 −1 1 −1 −1 −1 1 1 −1 −1 1 1 1 −1 −1 −1 1 1 1 −1 1 −1 1 1 1 −1 −1 1 −1 |
| | −1 −1 −1 −1 1 1 −1 −1 1 1 1 1 1 1 −1 −1 −1 1 −1 −1 −1 −1 1 −1 −1 −1 −1 1 1 1 −1 |
| | 1 1 −1 1 1 −1 −1 1 −1 1 −1 1 1 −1 1 1 −1 1 −1 1 −1 −1 1 −1 1 −1 1 1 1 −1 −1 −1 1 |
| | 1 −1 −1 1 −1 1 1 1 −1 1 −1 −1 1 −1 −1 1 −1 −1 −1 −1 −1 1 1 1 −1 −1 1 −1 1 −1 1 |
| | −1 1 −1 1 −1 −1 1 1 1 1 −1 −1 −1 1 1 −1 1 1 −1 1 1 1 −1 1 1 1 1 1 −1 1 1 1 1 −1 |
| | −1 −1 1 1 −1 1 −1 1 1 1 −1 1 1 1 1 −1 −1 1 −1 −1 1 −1 1 −1 −1 1 1 −1 1 1 1 1 −1 |
| | −1 1 1 1 −1 1 −1 1 1 −1 1 1 −1 1 1 1 1 −1 −1 −1 −1 −1 1 −1 1 −1 −1 −1 −1 −1 −1 |
| | 1 1 −1 1 1 1 1 −1 −1 1 −1 −1 −1 1 1 −1 1 −1 1 −1 1 −1 −1 −1 1 1 1 −1 −1 −1 1 −1 |
| | 1 1 −1 −1 1 −1 −1 1 1 1 −1 1 1 −1 −1 −1 −1 1 1 1 1 1 −1 −1 1 −1 1 −1 −1 −1 1 −1 |
| | 1 −1 −1 1 −1 −1 1 1 −1 −1 −1 −1 1 1 1 1 1 1 1 1 −1 −1 1 −1 −1 1 1 −1 1 1 −1 −1 1 |
| | −1 1 −1 −1 −1 −1 1 −1 1 1 −1 1 1 1 −1 1 −1 −1 −1 −1 1 −1 −1 −1 1 1 1 −1 1 1 1 1 |
| | 1 −1 −1 1 −1 1 1 −1 1 1 1 1 1 −1 1 1 −1 1 1 −1 1 1 −1 −1 1 1 1 1 1 −1 −1 −1 1 −1 |
| | −1 −1 1 −1 −1 −1 1 1 1 1 1 1 −1 −1 1 −1 1 1 1 1 −1 1 −1 1 1 1 1 1 1 1 −1 1 −1 1 |
| | −1 −1 1 1 1 1 −1 1 1 1 1 1 −1 1 −1 1 −1 −1 1 −1 −1 1 −1 −1 −1 1 1 1 1 −1 1 −1 1 |
| | −1 −1 1 −1 1 −1 −1 −1 1 −1 1 1 1 1 −1 1 −1 1 −1 −1 1 1 −1 −1 −1 1 −1 −1 1 1 −1 |
| | −1 1 −1 1 1 1 1 1 1 −1 −1 −1 1 1 −1 1 −1 −1 −1 1 −1 −1 −1 1 1 −1 1 −1 1 1 −1 −1 |
| | −1 1 −1 1 1 −1 1 1 −1 1 −1 1 1 1 1 −1 −1 1 1 1 1 1 1 1 −1 −1 −1 1 −1 −1 1 1 1 −1 |
| | 1 1 −1 1 1 −1 1 −1 −1 1 1 −1 1 −1 1 −1 1 −1 1 −1 −1 1 −1 −1 1 −1 1 1 1 1 −1 −1 |
| | −1 1 −1 −1 1 1 −1 1 1 1 1 −1 1 −1 1 1 1 −1 −1 1 1 1 −1 −1 1 −1 1 −1 −1 −1 −1 −1 |
| | −1 −1 1 1 1 −1 1 −1 −1 −1 −1 −1 −1 −1 1 −1 1 1 1 1 −1 1 −1 −1 1 −1 1 −1 1 −1 −1 |
| | 1 1 1 −1 −1 1 −1 −1 1 1 1 1 1 1 1 1 −1 −1 −1 1 −1 1 −1 1 1 1 −1 1 −1 1 −1 1 −1 1 |
| | 1 1 −1 1 1 −1 1 −1 1 −1 −1 −1 −1 −1 −1 −1 1 −1 −1 −1 1 1 1 −1 −1 −1 1 1 −1 1 −1 |
| | 1 −1 −1 −1 1 −1 −1 1 −1 −1 −1 1 1 −1 1 1 1 1 1 1 −1 1 1 1 −1 −1 −1 −1 1 1 −1 1 1 |
| | −1 1 −1 −1 1 −1 −1 −1 −1 −1 −1 −1 −1 1 1 −1 1 −1 −1 −1 1 1 −1 1 1 −1 −1 −1 −1 |
| | 1 −1 −1 −1 −1 1 1 −1 1 1 1 1 −1 1 −1 −1 −1 1 −1 1 −1 1 1 −1 1 −1 1 −1 1 −1 1 1 |
| | −1 −1 −1 1 1 1 1 1 −1 1 −1 −1 −1 −1 1 −1 −1 1 −1 1 1 1 −1 1 1 1 −1 1 1 −1 1 1 −1 |
| | 1 1 1 1 1 1 −1 −1 1 −1 −1 1 −1 1 1 1 1 1 1 −1 1 1 1 1 1 −1 −1 −1 −1 −1 1 1 1 −1 1 |
| | 1 −1 −1 1 1 −1 −1 −1 −1 −1 1 −1 −1 1 1 −1 −1 1 1 1 −1 1 −1 1 −1 −1 −1 1 1 1 −1 |
| | 1 1 1 −1 −1 −1 −1 −1 1 1 1 −1 −1 −1 −1 −1 −1 −1 −1 −1 −1 1 1 −1 1 1 1 −1 1 −1 1 |
| | 1 1 −1 1 1 1 −1 1 −1 1 1 1 1 −1 1 1 1 −1 −1 1 1 −1 −1 1 −1 −1 1 1 1 1 1 −1 −1 1 |
| | −1 1 1 1 −1 1 1 −1 −1 −1 1 1 1 −1 −1 1 −1 1 1 1 1 1 1 1 1 −1 1 −1 1 1 −1 −1 1 −1 |
| | 1 1 1 1 −1 1 1 −1 1 1 −1 −1 1 1 −1 −1 1 −1 1 1 1 −1 −1 1 −1 1 1 1 1 −1 −1 1 1 1 |
| | −1 −1 1 1 1 1 −1 1 −1 1 −1 −1 −1 1 1 −1 1 1 1 −1 1 −1 −1 −1 1 −1 −1 −1 1 −1 1 1 |
| | −1 −1 −1 −1 −1 −1 −1 1 −1 −1 1 1 −1 1 1 −1 1 1 1 1 1 −1 1 −1 1 1 1 1 −1 1 −1 −1 |
| | −1 −1 −1 −1 −1 −1 1 1 1 −1 −1 −1 1 −1 1 −1 1 −1 1 1 1 1 1 1 1 −1 −1 1 1 −1 1 −1 |
| | 1 1 1 1 −1 −1 −1 −1 1 1 −1 −1 1 −1 −1 1 −1 1 1 −1 1 −1 1 1 1 −1 1 1 −1 −1 −1 −1 |
| | −1 1 −1 1 −1 −1 1 1 −1 −1 −1 −1 −1 1 1 −1 −1 1 1 −1 −1 1 1 1 1 −1 1 −1 1 1 1 −1 |
| | 1 −1 1 1 1 1 1 −1 1 1 1 1 1 1 −1 1 −1 1 1 −1 1 −1 −1 1 −1 −1 1 −1 1 −1 1 −1 −1 1 |
| | −1 −1 −1 −1 −1 1 −1 1 1 −1 −1 −1 −1 −1 1 1 1 −1 1 −1 1 −1 1 −1 1 −1 −1 −1 1 −1 |
| | 1 1 −1 1 1 1 1 1 1 −1 1 −1 −1 −1 −1 1 1 1 1 −1 −1 −1 1 −1 1 −1 −1 1 −1 −1 −1 −1 |
| | −1 −1 1 1 1 1 1 −1 −1 −1 −1 −1 −1 1 −1 −1 −1 1 1 −1 1 −1 −1 −1 −1 −1 1 −1 −1 1 |
| | 1 1 −1 −1 1 −1 −1 −1 −1 1 1 −1 −1 1 1 −1 1 1 −1 1 −1 −1 −1 −1 1 −1 1 −1 1 −1 −1 |
| | −1 1 −1 1 −1 1 1 1 −1 −1 1 1 −1 −1 1 1 1 1 1 −1 −1 1 −1 −1 −1 1 −1 −1 −1 −1 −1 |
| | −1 −1 −1 −1 1 1 1 1 −1 1 1 1 1 1 1 −1 −1 1 1 1 1 −1 −1 −1 1 1 1 −1 1 −1 −1 −1 1 |
| | −1 1 −1 −1 −1 −1 1 1 −1 −1 1 −1 −1 −1 1 1 1 1 −1 −1 1 1 −1 1 −1 −1 1 −1 1 1 −1 |
| | 1 −1 1 −1 −1 −1 1 −1 1 −1 −1 −1 1 −1 1 −1 1 −1 −1 −1 −1 −1 −1 −1 −1 1 −1 −1 |
| | −1 −1 1 −1 −1 1 −1 −1 1 −1 −1 −1 1 −1 −1 1 −1 −1 1 1 −1 −1 −1 1 −1 1 1 −1 −1 1 |
| | 1 1 1 1 −1 1 1 1 −1 1 1 1 −1 −1 1 −1 −1 −1 −1 1 −1 1 −1 1 −1 1 1 1 −1 −1 1 1 1 1 |
| | 1 1 −1 −1 1 −1 −1 −1 1 1 1 −1 −1 1 1 −1 −1 −1 −1 −1 −1 −1 1 1 −1 −1 1 1 1 −1 −1 |
| | 1 −1 1 1 1 −1 −1 1 1 −1 1 1 −1 1 −1 1 1 −1 1 1 −1 −1 1 −1 1 1 −1 1 −1 −1 −1 −1 1 |
| | −1 −1 1 1 −1 1 1 1 −1 1 1 −1 −1 −1 1 −1 −1 −1 −1 −1 1 1 1 1 −1 −1 −1 −1 −1 −1 |
| | −1 1 1 1 −1 −1 1 −1 −1 1 1 −1 −1 1 1 −1 −1 −1 −1 −1 −1 1 −1 1 −1 1 −1 1 1 −1 1 |
| | −1 1 −1 −1 1 1 1 1 1 −1 1 1 −1 −1 −1 1 −1 −1 1 1 −1 1 −1 −1 1 −1 −1 1 1 1 1 1 1 |
| | −1 −1 −1 −1 1 −1 −1 1 −1 −1 −1 −1 1 −1 −1 −1 1 1 −1 1 1 1 −1 −1 1 −1 −1 −1 1 |
| | −1 −1 1 1 −1 1 1 −1 1 1 −1 −1 1 −1 −1 1 −1 −1 1 −1 −1 1 1 1 −1 −1 −1 1 1 1 1 |
| | −1 −1 1 −1 −1 −1 −1 1 1 1 1 1 1 1 −1 1 −1 1 1 1 1 1 −1 −1 −1 1 1 −1 −1 −1 1 −1 |
| | −1 −1 1 −1 1 −1 −1 1 −1 1 −1 1 −1 1 1 −1 1 1 −1 −1 −1 −1 −1 1 1 1 1 −1 −1 1 1 |
| | −1 −1 1 −1 1 1 −1 1 −1 1 1 −1 1 1 1 1 1 −1 −1 −1 −1 1 −1 1 1 1 −1 1 −1 −1 −1 −1 |
| | 1 1 1 −1 1 −1 −1 −1 1 1 −1 −1 −1 1 1 1 1 −1 1 −1 1 1 1 1 −1 −1 1 −1 −1 1 1 −1 −1 |
| | −1 −1 −1 −1 1 1 −1 −1 1 1 −1 1 −1 1 1 −1 1 1 −1 1 −1 −1 1 −1 1 1 −1 −1 1 1 −1 1 |
| | 1 1 −1 1 1 1 1 −1 1 1 1 −1 −1 −1 −1 −1 −1 −1 1 −1 1 1 −1 −1 −1 1 1 1 −1 1 1 −1 |
| | 1 1 −1 1 −1 1 −1 1 −1 −1 1 1 −1 1 1 −1 1 1 −1 −1 1 −1 −1 1 1 1 1 −1 1 −1 1 1 −1 1 |
| | 1 −1 −1 −1 1 1 1 1 −1 −1 −1 −1 1 −1 1 1 −1 1 1 −1 1 1 −1 1 1 −1 1 −1 1 1 −1 −1 |
| | −1 −1 −1 −1 1 1 1 −1 −1 1 1 1 1 1 1 1 1 1 −1 1 1 1 1 1 1 1 −1 −1 1 −1 1 1 −1 −1 |
| | −1 1 1 −1 1 1 1 −1 −1 −1 1 −1 −1 −1 1 −1 1 1 1 1 −1 −1 1 1 −1 1 −1 1 −1 −1 1 −1 |
| | 1 1 −1 1 1 1 1 −1 1 1 1 1 −1 1 −1 1 −1 1 1 −1 −1 1 −1 −1 −1 −1 −1 1 −1 −1 1 1 −1 |
| | 1 −1 1 1 1 −1 −1 1 −1 1 1 −1 −1 −1 −1 −1 −1 1 −1 −1 −1 −1 −1 −1 1 1 1 −1 −1 −1 |
| | −1 1 1 −1 −1 1 1 1 1 −1 −1 −1 −1 1 −1 −1 −1 −1 1 −1 1 1 1 −1 −1 −1 1 −1 1 1 −1 |
| | 1 −1 −1 −1 −1 −1 1 −1 1 −1 1 1 1 1 1 −1 −1 1 1 −1 −1 1 −1 −1 −1 −1 1 1 −1 1 −1 |
| | 1 −1 −1 −1 −1 1 −1 1 1 1 −1 1 1 1 −1 −1 −1 −1 1 −1 1 1 1 1 −1 −1 −1 1 1 1 1 1 1 |
| | −1 1 1 1 1 −1 1 −1 −1 1 1 1 1 1 1 −1 −1 1 1 1 −1 1 −1 −1 −1 −1 1 −1 1 1 1 1 −1 1 |
| | 1 1 1 −1 −1 1 1 −1 −1 −1 −1 −1 1 1 1 1 1 1 1 1 1 1 1 −1 1 −1 1 −1 1 −1 1 1 −1 1 1 |
| | 1 1 −1 −1 1 −1 1 1 1 1 1 −1 −1 1 −1 −1 1 1 1 −1 1 −1 1 −1 −1 1 −1 1 1 1 −1 1 1 −1 |
| | 1 1 1 1 −1 1 −1 1 −1 −1 −1 −1 −1 −1 1 −1 −1 −1 1 1 1 1 −1 1 1 −1 −1 1 1 1 −1 |
| | −1 −1 −1 1 −1 −1 −1 −1 −1 1 1 1 −1 1 −1 −1 1 1 −1 −1 1 −1 −1 1 1 −1 −1 1 −1 1 |
| | −1 −1 1 1 −1 1 −1 −1 1 −1 1 −1 1 1 −1 −1 1 −1 −1 1 1 −1 1 1 1 1 1 −1 −1 1 −1 −1 |
| | −1 −1 1 −1 −1 1 1 −1 −1 −1 1 −1 −1 −1 −1 −1 −1 −1 1 1 1 1 −1 −1 −1 1 1 −1 −1 |
| | −1 −1 1 −1 −1 −1 1 1 −1 −1 −1 1 −1 1 −1 −1 −1 −1 −1 1 1 −1 −1 −1 1 −1 1 −1 1 1 |
| | −1 −1 −1 −1 −1 −1 −1 −1 1 −1 1 −1 1 1 1 −1 −1 −1 −1 −1 −1 −1 −1 1 1 1 1 1 −1 1 |
| | 1 −1 −1 1 −1 −1 −1 −1 −1 −1 1 −1 1 −1 1 1 −1 1 −1 −1 1 1 |
| 13 | −1 −1 −1 −1 −1 −1 −1 −1 −1 −1 −1 −1 −1 1 −1 −1 −1 1 1 1 1 1 1 1 1 1 −1 −1 −1 1 |
| | 1 1 −1 −1 1 1 1 1 1 −1 1 −1 1 1 −1 1 1 1 −1 −1 −1 1 −1 −1 1 −1 1 −1 1 −1 1 1 1 −1 |
| | 1 −1 −1 −1 1 1 −1 −1 −1 −1 1 1 1 −1 1 1 1 1 1 1 −1 −1 −1 −1 1 −1 1 −1 −1 1 −1 1 |
| | 1 −1 1 −1 −1 −1 −1 1 −1 1 −1 1 1 1 −1 1 1 1 1 −1 −1 −1 1 −1 −1 1 1 1 −1 −1 1 −1 |
| | −1 1 −1 1 −1 −1 −1 −1 −1 1 1 1 1 −1 −1 1 1 −1 1 1 −1 1 −1 1 −1 −1 −1 1 1 −1 1 1 |
| | −1 −1 1 1 −1 −1 1 1 1 1 1 1 −1 −1 −1 1 −1 1 −1 1 −1 −1 −1 1 1 −1 1 −1 1 −1 1 −1 |
| | −1 −1 1 1 1 1 1 1 1 −1 −1 −1 −1 1 1 1 1 −1 −1 1 1 1 −1 1 −1 −1 −1 1 −1 −1 −1 1 1 |
| | −1 −1 1 −1 1 1 1 1 −1 −1 1 1 1 1 −1 1 1 1 1 1 −1 −1 1 1 −1 −1 −1 −1 −1 −1 1 −1 1 |
| | −1 1 1 −1 1 −1 −1 −1 1 1 −1 −1 1 −1 −1 1 −1 1 1 1 1 1 1 1 −1 1 1 −1 −1 1 1 1 1 −1 |
| | 1 1 1 −1 −1 −1 −1 −1 1 −1 −1 −1 −1 −1 −1 1 1 1 −1 −1 1 −1 −1 −1 1 −1 1 1 −1 1 |
| | −1 1 1 1 1 −1 1 1 −1 1 1 −1 1 1 −1 1 1 −1 −1 −1 −1 −1 1 −1 −1 1 −1 −1 1 −1 −1 |
| | −1 −1 −1 1 −1 −1 −1 −1 1 −1 −1 1 −1 1 −1 1 −1 −1 −1 1 −1 −1 −1 −1 −1 1 1 −1 |
| | −1 −1 1 1 1 −1 −1 1 −1 1 −1 1 1 −1 −1 1 1 −1 1 1 1 1 1 −1 −1 1 −1 −1 1 −1 1 1 −1 |
| | 1 −1 1 −1 1 1 1 −1 −1 1 1 1 −1 1 1 −1 −1 −1 1 1 1 1 1 −1 −1 1 −1 −1 −1 −1 −1 1 1 |
| | −1 −1 1 −1 1 1 1 −1 1 −1 1 −1 1 1 −1 1 1 1 1 1 1 −1 1 −1 −1 −1 1 −1 1 −1 1 −1 1 1 |
| | −1 −1 1 1 1 1 −1 1 −1 −1 −1 −1 1 −1 −1 1 −1 −1 −1 −1 −1 1 1 1 −1 −1 −1 −1 −1 1 |
| | −1 1 −1 1 −1 1 −1 1 1 −1 −1 1 −1 −1 1 −1 −1 −1 −1 −1 −1 1 −1 −1 1 1 −1 −1 1 −1 |
| | 1 −1 1 1 −1 −1 −1 −1 −1 1 −1 1 1 1 −1 −1 1 −1 −1 −1 −1 1 −1 −1 1 1 1 1 1 1 1 −1 |
| | 1 −1 −1 −1 −1 −1 −1 −1 −1 1 1 1 −1 −1 1 1 1 −1 1 1 1 1 −1 1 −1 1 1 1 −1 −1 1 −1 |
| | −1 1 −1 −1 −1 1 −1 1 1 1 1 1 1 −1 −1 1 −1 1 1 −1 1 1 1 −1 1 1 −1 1 1 1 1 1 −1 1 |
| | −1 1 1 −1 −1 −1 1 −1 1 −1 1 −1 −1 1 −1 1 −1 −1 −1 1 −1 1 −1 −1 −1 1 −1 1 1 −1 1 |
| | 1 1 −1 1 −1 1 1 1 −1 1 1 −1 1 −1 1 1 −1 1 −1 1 1 1 −1 −1 −1 1 1 −1 1 −1 1 1 −1 1 |
| | 1 1 1 −1 1 1 1 1 1 −1 1 −1 1 −1 1 −1 −1 −1 −1 1 −1 1 −1 −1 1 −1 −1 −1 −1 1 1 −1 |
| | −1 −1 1 −1 1 −1 1 −1 1 −1 −1 1 1 −1 −1 1 −1 1 −1 −1 −1 −1 −1 1 −1 −1 1 −1 1 1 1 |
| | −1 1 1 −1 1 −1 −1 −1 −1 1 1 1 1 1 −1 −1 −1 1 1 1 1 −1 −1 1 −1 −1 1 −1 1 −1 1 1 |
| | −1 −1 −1 1 1 1 −1 −1 1 1 −1 −1 1 −1 −1 −1 1 1 −1 1 1 1 −1 1 −1 1 1 −1 1 1 1 1 1 |
| | −1 1 1 −1 1 −1 1 −1 1 −1 1 −1 1 −1 −1 −1 −1 1 1 −1 −1 −1 −1 −1 −1 −1 −1 1 1 −1 |
| | −1 1 1 −1 −1 −1 1 1 1 1 −1 1 1 −1 1 −1 1 −1 −1 1 1 −1 −1 −1 −1 −1 −1 1 1 −1 −1 |
| | 1 −1 −1 1 −1 −1 −1 1 1 −1 1 1 −1 1 1 −1 −1 1 −1 1 1 1 1 1 −1 −1 1 −1 −1 −1 1 1 1 |
| | 1 1 −1 1 −1 1 1 1 −1 1 1 1 −1 −1 1 −1 −1 1 −1 1 1 1 −1 −1 1 1 1 1 1 −1 −1 1 1 1 1 |
| | 1 1 1 −1 −1 −1 1 −1 1 1 −1 −1 −1 1 1 1 −1 1 −1 1 −1 1 1 −1 −1 −1 1 1 −1 1 −1 1 |
| | −1 −1 −1 1 −1 −1 −1 1 1 1 1 1 −1 −1 1 1 1 −1 −1 1 1 1 −1 −1 1 −1 1 1 −1 −1 1 1 1 |
| | −1 −1 1 1 1 1 1 1 −1 −1 1 −1 −1 1 1 1 −1 −1 −1 1 1 −1 1 1 1 −1 −1 −1 −1 1 1 −1 1 |
| | 1 1 1 −1 1 1 1 −1 −1 −1 1 1 1 −1 1 −1 −1 −1 −1 1 1 1 −1 1 1 −1 1 −1 1 1 1 −1 −1 1 |
| | −1 1 −1 −1 −1 1 1 −1 1 1 1 1 1 1 1 −1 1 1 1 1 1 1 −1 1 −1 1 1 1 −1 −1 −1 1 −1 1 1 |
| | −1 −1 1 −1 1 1 1 1 −1 1 −1 1 1 −1 −1 1 1 1 1 1 −1 −1 −1 1 −1 1 −1 −1 1 −1 −1 −1 |
| | 1 −1 1 −1 1 −1 1 −1 1 −1 1 −1 1 1 −1 1 −1 −1 −1 −1 −1 −1 −1 −1 −1 −1 1 −1 1 1 1 |
| | 1 −1 1 1 1 1 1 1 −1 −1 1 1 1 −1 −1 −1 −1 1 −1 1 1 −1 1 1 −1 −1 1 1 −1 −1 −1 −1 1 |
| | 1 −1 1 −1 −1 −1 1 −1 1 −1 −1 −1 −1 1 1 1 1 1 1 1 −1 1 −1 1 1 −1 −1 1 −1 −1 1 1 1 |
| | −1 −1 1 −1 1 −1 −1 1 1 −1 −1 −1 −1 1 1 1 1 1 −1 1 −1 −1 1 −1 −1 −1 −1 1 −1 −1 1 |
| | −1 −1 1 1 −1 1 −1 1 −1 −1 −1 −1 −1 1 −1 −1 −1 1 1 1 −1 −1 1 1 −1 1 −1 −1 −1 1 1 |
| | 1 −1 1 1 1 −1 1 1 1 1 1 1 1 −1 1 −1 −1 1 1 −1 −1 1 −1 1 1 1 −1 −1 1 1 −1 −1 1 −1 |
| | 1 1 1 1 1 1 1 1 −1 1 −1 1 1 1 1 1 −1 1 1 1 1 −1 −1 1 −1 1 1 −1 1 −1 −1 −1 1 −1 −1 |
| | 1 1 1 1 1 −1 1 1 1 1 1 −1 −1 −1 −1 −1 −1 1 −1 −1 −1 1 −1 1 −1 1 −1 −1 1 1 −1 −1 |
| | −1 1 1 −1 1 −1 −1 −1 1 −1 −1 1 −1 −1 1 1 1 1 1 1 1 1 −1 −1 −1 1 −1 −1 −1 −1 −1 |
| | 1 1 1 1 −1 1 −1 1 −1 −1 1 −1 1 −1 1 −1 −1 −1 −1 1 −1 −1 1 −1 1 1 −1 −1 −1 1 1 |
| | −1 −1 −1 −1 −1 1 1 1 −1 −1 −1 1 1 1 −1 −1 −1 1 −1 1 −1 1 1 −1 1 1 −1 1 1 −1 1 |
| | −1 1 −1 −1 1 −1 1 −1 −1 1 −1 −1 1 1 −1 −1 1 −1 1 1 −1 1 −1 1 −1 −1 −1 1 −1 1 1 |
| | 1 1 −1 1 1 −1 −1 1 1 1 −1 1 1 1 −1 −1 −1 −1 −1 −1 1 −1 −1 1 −1 −1 1 1 1 −1 −1 1 |
| | 1 −1 −1 −1 −1 1 −1 −1 −1 −1 1 1 1 −1 1 −1 −1 −1 −1 −1 −1 1 −1 −1 1 −1 1 −1 1 1 |
| | 1 −1 1 1 −1 −1 −1 −1 1 1 −1 −1 1 1 1 −1 −1 −1 −1 −1 −1 −1 1 1 −1 1 −1 −1 1 1 −1 |
| | −1 1 1 1 −1 1 1 1 1 1 −1 −1 1 −1 1 −1 −1 1 −1 −1 1 −1 1 −1 1 1 1 1 −1 1 −1 1 −1 |
| | −1 1 1 −1 −1 1 1 −1 −1 −1 1 −1 −1 1 −1 −1 1 −1 1 −1 1 −1 −1 1 −1 −1 −1 1 −1 −1 |
| | 1 1 −1 −1 −1 1 −1 1 −1 1 1 −1 −1 −1 −1 1 −1 −1 1 −1 1 −1 −1 1 −1 −1 −1 −1 −1 |
| | −1 −1 −1 1 1 −1 1 −1 1 −1 1 −1 1 1 1 1 −1 1 1 1 1 −1 −1 −1 −1 −1 1 1 −1 −1 −1 |
| | −1 1 −1 −1 1 −1 −1 1 −1 1 1 −1 −1 −1 −1 −1 −1 −1 1 −1 −1 1 1 1 −1 −1 −1 −1 1 1 |
| | 1 −1 −1 −1 −1 −1 −1 1 1 −1 −1 −1 1 −1 1 1 −1 −1 1 1 −1 1 1 −1 −1 1 −1 1 1 −1 −1 |
| | 1 −1 1 1 −1 −1 −1 1 1 1 1 −1 −1 1 1 1 1 −1 −1 −1 1 1 −1 −1 −1 1 1 −1 −1 −1 −1 1 |
| | −1 1 1 1 −1 −1 1 1 1 −1 −1 −1 −1 −1 1 1 1 1 1 1 −1 −1 1 1 −1 −1 1 −1 1 −1 −1 1 1 |
| | −1 1 1 −1 1 −1 1 1 1 −1 1 −1 −1 1 1 −1 −1 1 1 −1 1 1 1 −1 1 1 −1 −1 1 −1 1 −1 1 1 |
| | −1 1 1 −1 −1 −1 −1 1 1 1 −1 −1 1 −1 1 −1 −1 −1 −1 −1 −1 1 −1 1 1 1 1 1 −1 1 1 |
| | −1 1 1 −1 −1 1 1 1 −1 1 −1 −1 −1 −1 1 −1 −1 −1 1 −1 −1 1 −1 1 1 1 −1 −1 −1 −1 1 |
| | 1 −1 −1 −1 1 1 1 1 1 1 −1 −1 −1 1 1 −1 −1 1 1 −1 −1 1 1 −1 1 −1 1 1 1 −1 1 −1 1 |
| | −1 1 −1 1 1 1 −1 1 1 1 −1 1 −1 −1 −1 −1 −1 1 1 1 −1 −1 1 1 −1 1 1 1 −1 1 −1 1 −1 |
| | 1 1 1 −1 1 1 1 −1 1 1 −1 1 −1 −1 −1 1 1 1 −1 −1 −1 1 −1 −1 1 1 1 1 1 1 −1 1 1 −1 1 |
| | −1 −1 −1 −1 −1 −1 1 1 −1 −1 −1 −1 1 1 1 1 −1 1 1 −1 1 1 −1 −1 −1 −1 1 −1 −1 −1 |
| | −1 −1 −1 1 −1 −1 −1 −1 −1 −1 −1 −1 1 −1 1 1 −1 −1 −1 1 −1 1 1 1 1 −1 −1 1 1 −1 |
| | −1 −1 1 −1 1 1 1 −1 −1 1 1 −1 1 −1 −1 1 −1 1 1 1 1 1 1 −1 1 1 1 1 −1 1 1 1 1 −1 1 |
| | 1 −1 −1 −1 1 −1 −1 −1 −1 1 −1 −1 −1 −1 −1 −1 −1 1 −1 −1 1 −1 −1 −1 −1 1 −1 1 |
| | 1 1 −1 −1 −1 −1 1 −1 1 −1 −1 −1 1 1 1 1 1 −1 −1 −1 −1 1 −1 1 1 1 1 −1 −1 1 −1 1 |
| | −1 −1 −1 −1 1 1 1 −1 −1 1 1 1 1 −1 1 1 −1 −1 1 −1 1 1 1 −1 −1 −1 −1 −1 −1 −1 −1 |
| | 1 1 1 1 1 1 1 −1 −1 1 1 1 1 −1 1 −1 −1 1 1 1 −1 1 1 −1 −1 −1 −1 −1 1 1 −1 −1 −1 1 |
| | −1 −1 −1 −1 −1 −1 1 −1 1 1 −1 −1 1 −1 −1 1 −1 1 1 −1 −1 1 1 −1 −1 1 1 −1 −1 1 1 |
| | 1 −1 −1 1 −1 1 −1 1 −1 1 −1 1 −1 −1 1 1 1 1 1 −1 −1 −1 −1 −1 −1 −1 1 −1 −1 −1 |
| | −1 1 −1 1 −1 −1 1 1 1 −1 −1 −1 1 −1 −1 −1 1 −1 1 −1 −1 −1 1 1 −1 1 −1 −1 1 1 −1 |
| | 1 −1 1 1 1 1 1 1 1 1 −1 −1 1 1 1 −1 1 1 −1 1 1 1 1 −1 1 1 −1 −1 1 −1 −1 −1 1 −1 1 |
| | −1 −1 −1 −1 −1 −1 1 1 −1 1 1 −1 1 −1 1 1 −1 1 1 −1 1 1 1 −1 −1 1 1 −1 1 −1 1 −1 |
| | −1 1 −1 1 1 1 1 −1 1 1 1 −1 −1 1 −1 1 1 1 1 −1 −1 −1 −1 1 1 1 1 1 1 1 1 −1 −1 1 |
| | −1 −1 −1 1 −1 −1 1 1 1 1 −1 1 1 1 −1 1 1 −1 −1 −1 −1 −1 −1 −1 −1 −1 1 1 −1 −1 |
| | −1 −1 −1 −1 1 1 1 1 1 −1 1 1 −1 −1 −1 1 1 −1 1 −1 −1 1 −1 −1 −1 −1 −1 −1 1 1 1 |
| | 1 1 1 −1 1 −1 1 −1 1 1 −1 1 −1 −1 1 1 −1 −1 1 −1 −1 −1 1 −1 1 1 1 −1 −1 1 −1 1 1 |
| | −1 1 1 −1 1 1 1 1 1 1 1 1 1 −1 1 −1 −1 1 −1 1 −1 1 1 1 1 1 −1 −1 1 1 −1 1 1 −1 −1 |
| | 1 1 −1 1 −1 1 1 −1 1 1 −1 −1 −1 1 −1 1 1 1 −1 1 −1 1 −1 −1 −1 −1 1 −1 1 1 1 1 −1 |
| | 1 −1 −1 1 1 −1 −1 −1 1 1 1 −1 −1 −1 1 1 −1 −1 1 −1 −1 1 1 −1 1 1 −1 1 1 1 −1 1 1 |
| | −1 −1 −1 1 1 −1 −1 1 −1 1 1 −1 −1 −1 −1 −1 1 1 1 −1 1 1 1 1 −1 −1 −1 −1 1 −1 1 |
| | −1 1 −1 −1 1 −1 −1 1 −1 −1 −1 −1 1 −1 −1 −1 1 −1 1 −1 −1 1 −1 1 −1 −1 −1 −1 1 |
| | 1 −1 1 −1 1 −1 1 1 −1 1 1 −1 −1 1 1 1 1 −1 −1 −1 1 −1 1 −1 −1 −1 1 −1 −1 −1 −1 |
| | 1 −1 1 −1 1 −1 1 1 1 −1 −1 1 −1 −1 −1 1 −1 −1 −1 −1 1 1 1 1 1 1 −1 1 1 −1 −1 1 |
| | −1 −1 1 −1 −1 1 1 −1 −1 −1 −1 −1 1 1 −1 −1 1 −1 −1 −1 1 −1 −1 −1 1 −1 1 1 −1 1 |
| | 1 −1 1 1 −1 −1 1 1 −1 1 1 −1 1 −1 −1 1 −1 −1 −1 1 −1 1 1 −1 −1 1 1 1 −1 1 −1 1 1 |
| | −1 1 1 −1 −1 1 −1 −1 1 −1 1 −1 1 −1 1 −1 −1 −1 1 1 −1 −1 1 1 −1 −1 −1 −1 −1 1 1 |
| | 1 1 1 −1 1 −1 1 −1 −1 −1 1 −1 1 −1 −1 1 −1 −1 1 −1 −1 1 1 1 −1 1 −1 1 −1 1 −1 |
| | −1 1 −1 −1 −1 −1 1 −1 1 −1 −1 −1 −1 1 −1 1 −1 1 −1 −1 −1 1 −1 1 1 −1 −1 −1 1 |
| | −1 −1 −1 1 1 1 −1 1 1 −1 −1 −1 1 −1 −1 1 1 1 −1 1 −1 −1 −1 −1 −1 1 −1 −1 −1 −1 |
| | −1 1 −1 1 1 1 −1 1 −1 −1 −1 1 −1 1 −1 −1 1 1 1 1 −1 1 1 1 1 −1 1 −1 1 −1 −1 −1 |
| | −1 −1 −1 −1 1 −1 −1 −1 1 −1 −1 1 1 −1 1 1 1 −1 −1 −1 1 1 −1 −1 −1 −1 1 1 −1 1 1 |
| | 1 −1 1 1 1 −1 −1 −1 −1 1 1 1 −1 1 1 −1 −1 1 1 1 −1 −1 −1 1 −1 1 −1 −1 −1 −1 1 |
| | −1 −1 1 1 −1 1 −1 1 −1 1 1 −1 −1 −1 −1 −1 −1 1 1 1 −1 −1 −1 1 −1 −1 −1 −1 1 1 |
| | −1 1 −1 1 1 −1 1 −1 −1 1 −1 −1 1 1 1 1 −1 1 −1 1 1 1 −1 1 −1 −1 −1 −1 −1 −1 −1 |
| | 1 −1 1 1 1 −1 1 1 1 −1 1 1 1 −1 −1 1 1 1 1 −1 −1 1 1 −1 −1 1 1 1 1 −1 −1 −1 −1 1 |
| | 1 −1 1 −1 1 −1 −1 −1 −1 1 −1 −1 −1 1 1 1 1 −1 −1 1 1 −1 −1 −1 −1 1 1 1 −1 −1 −1 |
| | 1 1 −1 1 −1 −1 −1 −1 1 −1 1 1 −1 1 1 1 1 1 1 1 −1 −1 −1 1 1 −1 1 −1 1 −1 1 1 1 −1 |
| | 1 −1 1 1 1 1 1 −1 −1 −1 1 1 1 −1 1 −1 1 1 −1 1 −1 1 −1 1 1 −1 1 −1 1 −1 1 −1 1 1 |
| | −1 −1 −1 1 −1 1 1 −1 −1 −1 −1 −1 1 −1 −1 −1 1 −1 1 1 −1 −1 −1 −1 1 −1 −1 −1 1 |
| | 1 −1 1 1 −1 −1 −1 −1 −1 −1 −1 1 1 1 1 1 −1 −1 −1 −1 −1 1 1 1 −1 1 −1 −1 1 −1 1 |
| | −1 −1 1 −1 1 −1 1 −1 1 1 −1 1 1 −1 1 −1 1 1 −1 −1 −1 −1 1 −1 1 −1 −1 1 1 −1 1 |
| | −1 −1 −1 −1 −1 −1 1 −1 1 −1 −1 1 1 1 1 1 −1 1 1 −1 −1 1 −1 1 −1 −1 −1 −1 1 −1 |
| | −1 −1 −1 −1 1 1 1 −1 1 1 −1 −1 −1 −1 1 −1 1 −1 1 −1 1 −1 −1 −1 −1 −1 −1 −1 −1 |
| | 1 −1 −1 −1 −1 −1 1 1 −1 1 1 1 1 −1 −1 −1 1 −1 1 −1 1 1 1 −1 1 −1 −1 1 −1 1 −1 1 |
| | −1 −1 1 1 1 −1 1 1 −1 1 1 −1 −1 −1 1 −1 −1 −1 1 −1 −1 −1 1 −1 −1 −1 −1 1 −1 −1 |
| | 1 1 −1 −1 1 1 −1 −1 1 −1 −1 −1 −1 −1 −1 1 −1 1 −1 1 −1 1 1 −1 1 −1 1 1 −1 −1 1 |
| | −1 −1 −1 −1 1 −1 1 1 −1 1 −1 −1 1 1 −1 1 −1 −1 −1 1 1 −1 1 1 1 −1 −1 1 1 1 1 1 1 |
| | 1 1 1 −1 1 1 1 1 −1 −1 −1 1 1 1 1 1 −1 −1 −1 1 −1 −1 1 −1 1 1 −1 −1 1 −1 1 −1 1 |
| | −1 −1 −1 1 1 1 −1 −1 1 1 1 −1 −1 −1 1 1 1 1 −1 1 1 1 −1 −1 1 1 −1 1 1 −1 −1 −1 |
| | −1 −1 1 1 1 1 −1 1 1 −1 −1 −1 −1 −1 1 −1 1 −1 −1 −1 −1 −1 −1 −1 −1 −1 1 −1 −1 |
| | 1 −1 1 1 −1 1 1 1 1 1 −1 −1 −1 −1 1 1 1 −1 1 −1 1 −1 1 −1 1 −1 −1 −1 1 −1 1 −1 1 |
| | −1 −1 −1 −1 −1 −1 1 1 1 −1 1 −1 −1 −1 1 1 −1 1 1 −1 1 −1 1 −1 1 1 1 1 1 1 1 −1 |
| | −1 1 1 −1 −1 −1 1 1 −1 1 1 1 −1 1 1 −1 1 −1 −1 1 1 1 1 −1 1 1 −1 −1 −1 1 1 1 −1 |
| | −1 −1 −1 −1 −1 −1 −1 −1 −1 1 1 −1 1 1 −1 −1 1 1 1 1 1 1 −1 1 1 1 −1 −1 −1 1 −1 |
| | −1 −1 1 1 −1 −1 −1 1 1 1 −1 1 −1 −1 1 1 1 1 −1 −1 1 1 −1 1 −1 1 1 −1 −1 −1 −1 |
| | −1 1 1 −1 1 1 1 −1 1 −1 −1 −1 −1 1 −1 1 1 1 −1 1 1 −1 1 1 1 −1 −1 −1 1 1 1 1 −1 |
| | −1 −1 1 −1 1 1 1 −1 1 1 −1 −1 −1 1 −1 1 −1 1 1 1 1 −1 −1 −1 −1 −1 1 −1 1 −1 −1 |
| | 1 1 −1 −1 1 −1 −1 1 −1 −1 1 −1 1 −1 −1 1 −1 1 1 −1 −1 1 −1 −1 1 1 −1 1 −1 1 1 1 |
| | −1 −1 1 1 −1 −1 −1 1 1 1 −1 1 1 1 1 1 −1 1 −1 −1 1 1 −1 1 −1 −1 1 −1 1 −1 −1 1 1 |
| | −1 −1 1 1 1 1 −1 1 1 −1 1 −1 −1 1 −1 1 −1 −1 −1 −1 −1 −1 −1 1 1 1 −1 1 1 −1 1 1 |
| | −1 1 1 1 −1 1 −1 1 −1 −1 −1 1 −1 −1 1 −1 1 1 −1 1 −1 −1 1 1 1 −1 −1 −1 1 1 1 −1 |
| | 1 1 1 −1 −1 −1 1 1 −1 1 1 −1 1 −1 −1 1 1 1 −1 1 1 1 1 −1 −1 1 1 1 −1 −1 −1 1 −1 |
| | −1 1 −1 −1 1 1 −1 −1 1 1 −1 1 −1 −1 −1 1 −1 −1 −1 1 −1 1 −1 1 1 1 1 1 1 −1 −1 1 |
| | 1 −1 1 −1 −1 1 1 −1 1 1 −1 1 1 −1 1 1 1 1 −1 −1 1 1 −1 −1 1 −1 −1 1 −1 1 −1 −1 1 |
| | 1 −1 1 −1 1 1 −1 −1 1 1 −1 1 −1 −1 1 1 1 −1 1 −1 −1 1 −1 1 1 1 1 −1 −1 −1 1 −1 1 |
| | 1 −1 1 1 1 1 −1 −1 1 −1 1 −1 1 1 −1 1 −1 1 −1 −1 1 1 1 1 −1 −1 1 −1 1 1 −1 −1 1 |
| | −1 −1 −1 −1 −1 1 1 1 1 1 −1 −1 1 1 −1 1 −1 1 −1 1 −1 −1 1 −1 1 1 −1 1 1 1 −1 −1 |
| | −1 −1 1 −1 1 1 1 −1 1 −1 1 1 1 −1 −1 −1 1 1 1 1 1 −1 1 −1 1 1 1 1 −1 −1 −1 1 −1 |
| | −1 −1 −1 1 −1 1 1 −1 −1 1 −1 1 −1 −1 1 −1 −1 −1 1 1 −1 −1 1 1 1 −1 1 −1 1 −1 1 |
| | 1 1 1 −1 1 −1 −1 1 −1 1 −1 −1 −1 1 1 −1 −1 −1 1 1 −1 1 1 −1 1 1 1 1 1 −1 −1 1 1 1 |
| | 1 −1 −1 1 −1 1 −1 1 −1 1 1 −1 −1 −1 −1 1 1 1 1 −1 −1 −1 −1 1 −1 −1 −1 −1 −1 1 |
| | −1 −1 −1 1 −1 −1 −1 −1 −1 1 −1 1 −1 −1 −1 1 1 −1 −1 1 −1 1 −1 −1 1 −1 1 1 1 1 1 |
| | −1 1 1 1 −1 1 −1 1 1 1 1 −1 1 −1 −1 −1 1 1 −1 1 −1 1 1 −1 −1 −1 1 1 1 1 1 1 1 1 |
| | −1 1 −1 −1 −1 1 1 −1 −1 1 1 1 1 −1 −1 1 1 1 1 1 1 −1 1 −1 −1 −1 −1 1 1 −1 −1 −1 |
| | 1 1 −1 −1 1 1 1 −1 −1 1 1 −1 −1 1 1 1 −1 1 −1 −1 1 1 1 −1 1 −1 1 −1 −1 1 −1 1 1 |
| | −1 −1 −1 1 −1 1 −1 −1 1 −1 1 1 1 −1 −1 −1 1 −1 1 −1 1 −1 1 1 1 1 1 1 −1 1 −1 1 |
| | −1 −1 −1 −1 1 1 −1 1 1 −1 −1 1 −1 −1 1 1 −1 −1 1 1 1 −1 −1 −1 1 1 −1 −1 −1 1 −1 |
| | 1 −1 −1 1 1 −1 1 1 1 −1 −1 1 −1 1 −1 1 −1 −1 1 1 −1 1 1 1 1 1 1 −1 −1 −1 1 −1 −1 |
| | 1 1 −1 1 −1 1 1 −1 1 −1 1 −1 −1 −1 −1 1 1 1 −1 1 −1 1 1 −1 −1 1 1 −1 −1 1 −1 1 |
| | −1 1 −1 1 −1 −1 1 −1 1 −1 1 1 1 −1 −1 −1 −1 −1 1 −1 1 1 −1 −1 1 1 1 1 −1 −1 1 |
| | −1 −1 1 1 −1 −1 1 −1 −1 −1 −1 1 1 1 −1 −1 −1 1 −1 1 1 −1 1 −1 −1 1 −1 1 1 −1 1 |
| | −1 1 1 −1 1 1 1 −1 1 1 1 −1 1 1 −1 1 −1 1 −1 1 1 −1 −1 1 1 −1 −1 −1 1 1 −1 −1 −1 |
| | 1 −1 −1 1 −1 1 −1 −1 1 1 1 −1 −1 1 −1 −1 −1 1 1 −1 1 −1 −1 −1 1 1 1 1 −1 1 1 1 1 |
| | 1 1 1 1 1 1 −1 −1 −1 −1 −1 1 −1 1 1 1 1 1 1 −1 1 −1 −1 1 −1 −1 1 1 1 −1 1 1 −1 −1 |
| | 1 1 −1 1 −1 −1 −1 −1 1 −1 −1 −1 −1 1 −1 1 1 1 1 1 −1 −1 −1 −1 1 −1 −1 −1 1 1 1 |
| | −1 1 −1 1 −1 −1 −1 −1 −1 1 1 1 −1 1 −1 1 −1 −1 1 1 −1 1 −1 1 −1 1 −1 1 −1 −1 1 |
| | −1 −1 1 1 1 −1 −1 −1 −1 −1 −1 1 −1 1 −1 −1 −1 −1 1 1 −1 −1 1 1 −1 −1 1 −1 1 1 |
| | −1 −1 1 1 −1 1 −1 1 −1 1 1 1 1 −1 −1 1 −1 1 1 1 −1 −1 −1 1 1 −1 1 1 1 1 1 1 1 |
| | 1 −1 1 1 1 −1 1 −1 −1 −1 1 1 1 1 −1 −1 −1 1 1 −1 1 1 1 1 1 −1 −1 −1 1 −1 1 1 1 1 |
| | −1 1 −1 1 −1 1 −1 1 −1 1 1 1 −1 −1 −1 1 −1 −1 −1 −1 −1 −1 1 1 1 1 −1 1 −1 −1 |
| | 1 −1 1 1 1 −1 1 −1 −1 −1 −1 1 1 −1 1 1 1 1 1 −1 1 1 1 −1 −1 1 1 1 −1 1 −1 1 −1 −1 |
| | −1 1 1 1 1 −1 −1 1 −1 1 −1 −1 1 1 1 1 −1 −1 −1 1 1 1 1 −1 1 −1 −1 −1 −1 −1 1 −1 |
| | 1 1 −1 −1 −1 −1 1 1 1 −1 1 −1 −1 1 1 −1 −1 −1 −1 −1 1 −1 1 −1 1 1 −1 −1 1 −1 −1 |
| | −1 1 −1 −1 1 −1 −1 1 −1 −1 1 1 −1 1 1 −1 −1 −1 1 −1 −1 1 −1 −1 −1 1 1 −1 −1 −1 |
| | −1 1 −1 −1 −1 1 −1 1 1 1 1 −1 −1 −1 −1 −1 −1 1 1 −1 1 1 1 −1 −1 1 −1 −1 1 1 −1 |
| | 1 1 1 −1 1 1 1 1 1 −1 −1 −1 1 1 −1 1 1 −1 −1 1 −1 1 −1 1 −1 1 1 1 1 −1 −1 −1 1 1 |
| | 1 −1 −1 −1 −1 1 1 −1 −1 1 −1 1 1 −1 1 1 −1 −1 −1 1 1 −1 1 1 1 1 −1 1 −1 −1 −1 |
| | −1 1 1 1 1 −1 1 −1 −1 −1 1 1 1 −1 −1 1 −1 −1 −1 −1 1 1 1 1 1 −1 1 1 1 1 −1 1 −1 |
| | −1 1 −1 −1 1 −1 −1 −1 1 −1 −1 −1 1 1 −1 1 −1 −1 1 −1 1 1 −1 −1 1 1 1 1 1 1 −1 |
| | 1 1 1 −1 −1 1 −1 −1 −1 1 1 1 −1 −1 −1 1 1 1 1 1 −1 1 1 1 −1 1 1 −1 1 1 −1 −1 1 −1 |
| | −1 −1 1 1 −1 −1 −1 1 −1 −1 −1 1 1 −1 1 1 1 1 −1 −1 1 −1 −1 1 1 1 1 1 −1 1 −1 −1 |
| | 1 1 1 −1 −1 −1 −1 −1 1 −1 −1 1 1 −1 −1 −1 1 1 −1 −1 1 −1 −1 −1 −1 −1 1 −1 −1 1 |
| | 1 1 −1 1 1 −1 1 −1 1 −1 −1 −1 −1 −1 −1 1 −1 −1 −1 1 1 −1 −1 1 1 −1 1 1 −1 −1 −1 |
| | 1 1 1 1 −1 1 −1 1 1 −1 −1 −1 −1 1 1 −1 −1 −1 −1 1 −1 1 −1 −1 −1 −1 −1 1 1 −1 −1 |
| | −1 −1 −1 1 −1 1 1 −1 1 −1 1 1 −1 −1 −1 1 −1 −1 1 1 −1 1 1 −1 1 −1 −1 −1 1 −1 −1 |
| | −1 −1 1 1 −1 −1 1 1 1 1 1 −1 −1 1 −1 −1 1 1 −1 1 −1 −1 −1 1 −1 1 1 1 −1 −1 −1 1 |
| | 1 1 1 1 1 −1 1 1 1 1 1 −1 1 1 −1 −1 1 1 −1 −1 −1 1 −1 1 −1 −1 −1 −1 −1 1 −1 1 −1 |
| | −1 1 −1 1 −1 1 1 −1 1 −1 1 −1 1 −1 1 1 −1 −1 1 −1 1 1 1 −1 1 1 −1 −1 1 −1 −1 |
| | 1 1 1 1 1 1 −1 −1 −1 −1 1 1 −1 −1 −1 −1 −1 1 1 −1 1 −1 −1 −1 1 1 −1 −1 −1 1 −1 |
| | 1 1 1 1 1 1 1 1 1 −1 −1 1 −1 1 1 1 −1 1 1 1 1 1 −1 1 1 1 1 1 1 1 −1 −1 1 −1 1 −1 −1 |
| | −1 1 −1 1 1 1 −1 1 1 1 1 −1 1 1 1 −1 1 1 1 1 −1 −1 1 −1 −1 −1 −1 1 1 −1 −1 1 −1 |
| | −1 1 1 1 −1 1 −1 −1 1 1 −1 1 1 −1 −1 −1 −1 1 −1 1 1 −1 −1 1 1 −1 −1 −1 −1 −1 −1 |
| | −1 1 1 −1 −1 1 −1 1 −1 −1 −1 1 1 1 −1 1 1 −1 1 1 1 −1 1 1 1 1 −1 1 −1 −1 −1 1 −1 |
| | 1 1 −1 −1 1 −1 −1 −1 1 1 1 1 −1 1 1 −1 −1 1 1 −1 1 1 1 −1 −1 −1 −1 −1 −1 −1 1 |
| | −1 1 1 −1 1 1 1 −1 −1 1 1 1 −1 −1 1 1 −1 1 −1 1 1 1 1 −1 −1 1 1 1 −1 1 1 1 −1 1 1 |
| | −1 −1 1 1 −1 −1 1 −1 −1 1 1 −1 −1 −1 −1 1 −1 1 −1 1 1 −1 −1 −1 1 −1 −1 −1 −1 |
| | −1 1 −1 −1 1 −1 −1 −1 1 −1 −1 1 −1 1 −1 −1 −1 −1 1 −1 1 1 −1 −1 −1 1 1 −1 1 1 |
| | −1 −1 −1 1 1 −1 −1 −1 1 1 1 1 −1 −1 −1 −1 1 1 1 −1 −1 1 1 −1 −1 −1 1 −1 −1 −1 1 |
| | −1 1 1 1 −1 1 −1 −1 1 −1 −1 1 1 −1 1 1 1 1 −1 1 1 −1 1 −1 −1 −1 1 1 −1 1 −1 −1 |
| | −1 −1 −1 1 1 1 1 1 1 1 1 1 1 1 −1 1 −1 1 −1 −1 1 1 1 1 1 1 1 −1 −1 1 −1 −1 1 −1 |
| | −1 −1 −1 1 1 1 −1 1 1 1 −1 −1 1 −1 1 −1 −1 1 −1 1 −1 −1 1 1 1 1 1 1 −1 1 −1 1 1 |
| | −1 1 −1 −1 −1 −1 1 1 −1 −1 1 −1 1 −1 1 1 1 1 −1 −1 1 1 −1 1 1 1 −1 −1 1 1 −1 −1 |
| | 1 1 −1 1 1 −1 1 1 1 1 −1 1 −1 1 −1 1 1 −1 −1 1 −1 1 −1 −1 −1 1 −1 −1 −1 1 −1 −1 |
| | 1 1 1 −1 1 1 1 −1 −1 1 1 −1 −1 −1 −1 −1 1 −1 −1 1 1 1 1 −1 1 −1 −1 −1 1 −1 −1 |
| | −1 −1 −1 −1 −1 −1 −1 1 1 1 1 −1 −1 1 −1 1 1 1 1 1 −1 1 −1 −1 −1 1 1 1 1 1 1 −1 1 |
| | −1 −1 1 1 1 1 1 −1 −1 1 1 −1 −1 1 1 −1 −1 −1 −1 1 −1 1 1 −1 1 −1 1 −1 1 −1 −1 |
| | −1 −1 −1 1 1 −1 1 1 −1 −1 −1 −1 1 1 −1 1 −1 1 1 1 −1 −1 −1 −1 −1 −1 1 1 1 1 −1 |
| | 1 1 1 1 −1 −1 1 1 −1 1 −1 −1 −1 −1 −1 1 −1 −1 1 1 −1 1 1 1 1 1 −1 1 −1 −1 −1 −1 |
| | −1 1 1 −1 1 −1 1 −1 −1 1 1 1 −1 1 −1 1 1 1 1 −1 −1 1 −1 −1 −1 1 −1 1 −1 1 1 −1 |
| | −1 1 1 1 −1 1 1 −1 1 −1 −1 1 −1 −1 1 −1 −1 1 −1 −1 −1 1 1 1 −1 1 −1 −1 1 −1 −1 |
| | 1 −1 1 1 1 −1 1 −1 1 1 −1 1 −1 −1 1 1 1 1 1 −1 1 −1 1 −1 1 1 1 −1 −1 −1 −1 1 −1 |
| | −1 1 −1 −1 −1 1 1 1 1 −1 −1 −1 −1 −1 −1 1 −1 1 1 1 −1 −1 −1 1 −1 −1 1 1 −1 −1 1 |
| | 1 1 1 1 −1 1 −1 −1 −1 −1 1 −1 1 −1 −1 −1 1 −1 −1 1 1 1 −1 −1 −1 1 −1 1 1 1 −1 |
| | −1 −1 −1 −1 1 1 −1 1 −1 1 1 1 1 1 −1 −1 1 1 1 1 1 −1 1 1 −1 1 −1 1 1 1 1 1 1 |
| | −1 −1 −1 −1 −1 1 1 −1 1 1 −1 1 1 −1 1 −1 −1 1 −1 1 1 1 −1 −1 1 −1 −1 1 1 1 −1 1 |
| | 1 1 1 1 1 1 1 −1 −1 −1 −1 1 −1 −1 1 −1 1 1 1 1 −1 1 −1 −1 −1 −1 −1 −1 1 1 1 1 −1 |
| | −1 −1 1 1 1 −1 1 1 −1 1 −1 −1 −1 1 −1 1 1 −1 1 −1 −1 −1 1 1 1 1 1 −1 1 1 −1 1 1 1 |
| | 1 1 1 −1 −1 1 −1 −1 −1 −1 1 −1 1 −1 1 1 −1 1 1 1 −1 1 −1 −1 −1 1 −1 −1 1 −1 1 |
| | −1 1 1 −1 1 1 1 1 −1 −1 −1 1 1 −1 −1 1 −1 1 −1 1 −1 −1 1 −1 1 1 1 −1 1 1 1 −1 −1 |
| | −1 1 −1 1 1 1 1 1 −1 −1 1 1 1 −1 1 −1 1 1 1 −1 1 −1 1 1 −1 −1 1 −1 1 −1 1 1 1 −1 |
| | 1 −1 1 −1 −1 1 1 1 −1 −1 1 1 1 −1 1 −1 −1 1 −1 −1 −1 1 1 1 −1 −1 1 −1 1 1 −1 1 |
| | −1 1 1 1 −1 1 1 1 1 1 1 −1 1 1 −1 1 1 1 −1 −1 1 −1 1 1 −1 −1 −1 −1 1 −1 1 1 1 1 1 |
| | 1 1 −1 −1 −1 −1 −1 −1 1 1 1 −1 1 1 1 −1 1 −1 −1 1 1 −1 1 −1 1 −1 −1 1 1 −1 1 1 |
| | −1 −1 1 1 1 −1 −1 1 −1 −1 1 1 −1 −1 −1 1 −1 −1 1 1 1 1 −1 −1 −1 1 −1 −1 1 −1 −1 |
| | −1 −1 −1 −1 −1 1 −1 1 −1 −1 −1 1 −1 1 −1 1 1 1 −1 −1 1 −1 1 1 1 −1 1 −1 −1 1 1 |
| | 1 1 1 1 1 1 1 1 −1 1 1 −1 −1 −1 −1 1 1 1 1 1 1 −1 −1 −1 −1 −1 −1 −1 −1 1 −1 −1 1 |
| | 1 −1 1 −1 −1 1 1 1 1 −1 −1 −1 −1 −1 1 1 1 1 −1 −1 −1 −1 −1 1 −1 −1 1 −1 1 −1 −1 |
| | −1 1 −1 −1 1 −1 −1 −1 −1 1 1 −1 1 1 1 −1 −1 −1 1 −1 1 −1 −1 1 1 1 −1 1 1 1 −1 1 |
| | −1 1 −1 1 −1 −1 −1 1 −1 −1 1 1 −1 1 −1 −1 −1 −1 1 1 1 −1 −1 −1 −1 1 1 1 1 1 −1 |
| | −1 1 −1 1 1 −1 −1 −1 1 −1 −1 1 −1 1 1 1 1 1 −1 −1 −1 1 −1 −1 −1 1 1 1 1 −1 1 −1 |
| | 1 −1 1 −1 −1 1 1 1 −1 −1 −1 −1 1 −1 −1 −1 −1 1 −1 −1 −1 1 1 −1 −1 −1 −1 −1 1 |
| | −1 −1 −1 −1 1 1 1 1 −1 −1 −1 1 −1 −1 −1 1 −1 −1 1 −1 −1 −1 1 −1 1 −1 −1 1 1 −1 |
| | −1 −1 1 −1 1 1 −1 1 −1 1 −1 −1 1 −1 −1 1 −1 1 1 −1 1 1 −1 −1 1 −1 1 −1 −1 1 1 1 |
| | −1 1 −1 −1 −1 1 1 1 −1 1 −1 −1 −1 1 −1 1 1 1 1 1 −1 1 −1 1 1 1 1 −1 1 1 1 −1 1 −1 |
| | −1 1 −1 1 1 −1 −1 −1 −1 1 1 −1 1 1 −1 1 1 1 −1 −1 −1 −1 −1 1 1 1 −1 −1 1 −1 1 1 |
| | 1 −1 −1 1 −1 1 1 1 1 1 1 1 1 1 1 1 1 −1 −1 1 1 −1 1 1 1 1 1 1 1 1 −1 1 1 −1 1 |
| | 1 −1 1 −1 1 1 1 1 −1 −1 −1 −1 1 −1 −1 1 1 −1 1 1 −1 −1 1 −1 −1 −1 −1 −1 −1 −1 1 |
| | 1 −1 −1 −1 1 1 −1 1 −1 1 1 1 −1 1 1 −1 −1 1 1 1 1 1 −1 1 1 1 −1 −1 −1 −1 1 −1 −1 |
| | −1 1 −1 −1 −1 1 1 1 −1 −1 −1 −1 −1 1 1 −1 −1 1 1 1 −1 1 1 −1 −1 1 −1 1 1 −1 1 |
| | −1 −1 1 −1 −1 −1 −1 1 1 1 1 −1 1 1 1 −1 1 −1 1 −1 −1 1 −1 −1 −1 −1 −1 1 1 −1 1 |
| | −1 −1 1 −1 1 −1 1 −1 1 −1 1 1 1 1 1 −1 1 1 −1 −1 −1 −1 −1 −1 1 1 −1 1 −1 −1 −1 |
| | −1 −1 −1 −1 1 1 −1 1 1 1 1 1 1 −1 1 1 1 −1 1 1 1 −1 1 −1 1 1 −1 −1 −1 1 1 −1 −1 1 |
| | 1 −1 1 −1 1 −1 −1 −1 1 1 1 −1 1 −1 1 1 1 −1 −1 1 1 1 1 −1 1 −1 1 −1 1 1 1 1 1 −1 |
| | −1 −1 −1 −1 1 −1 −1 −1 1 1 −1 1 −1 1 −1 −1 1 −1 −1 −1 1 1 1 1 1 1 −1 −1 1 −1 1 |
| | −1 1 1 1 −1 −1 1 1 −1 1 1 1 1 −1 1 1 1 1 1 −1 1 1 −1 1 −1 −1 1 1 −1 −1 −1 1 −1 |
| | −1 −1 −1 1 1 1 −1 −1 1 −1 −1 1 −1 −1 1 −1 −1 1 −1 1 1 1 1 −1 −1 1 −1 −1 1 −1 −1 |
| | 1 1 1 1 −1 −1 1 1 1 −1 −1 1 −1 −1 −1 −1 −1 −1 1 1 −1 −1 1 1 1 1 −1 1 −1 1 1 −1 1 |
| | 1 −1 1 −1 −1 −1 −1 −1 1 −1 1 −1 1 −1 −1 1 1 1 1 −1 1 −1 −1 1 −1 −1 −1 1 −1 −1 |
| | −1 −1 −1 −1 1 1 −1 1 −1 1 1 −1 −1 1 −1 1 1 −1 1 1 1 1 −1 1 −1 −1 1 1 1 1 −1 1 −1 |
| | 1 −1 −1 −1 1 1 −1 −1 −1 −1 −1 −1 1 −1 −1 1 1 1 1 1 −1 −1 −1 1 1 −1 −1 −1 −1 −1 |
| | −1 −1 1 −1 1 −1 1 1 1 −1 −1 −1 1 1 1 −1 −1 1 −1 −1 1 1 1 1 −1 1 1 −1 1 1 1 1 −1 |
| | −1 −1 −1 −1 −1 −1 −1 −1 1 −1 1 −1 −1 1 −1 −1 1 1 1 1 1 −1 −1 1 −1 1 −1 1 −1 −1 |
| | −1 −1 −1 1 −1 1 1 1 1 −1 −1 −1 1 1 −1 1 −1 −1 1 1 1 −1 −1 1 −1 1 1 1 1 1 1 −1 −1 |
| | −1 1 1 1 1 1 1 1 −1 1 1 −1 1 −1 1 1 −1 −1 1 1 1 −1 −1 −1 −1 1 1 −1 1 −1 −1 1 −1 |
| | −1 1 1 −1 −1 −1 1 1 1 1 1 −1 1 −1 −1 −1 1 −1 −1 1 1 −1 −1 1 −1 −1 1 1 1 1 −1 −1 |
| | −1 −1 1 −1 1 1 −1 −1 −1 −1 −1 −1 1 −1 −1 −1 −1 1 1 −1 −1 −1 −1 1 1 −1 −1 −1 1 |
| | −1 −1 1 1 −1 −1 −1 −1 1 1 −1 −1 1 −1 −1 −1 −1 1 −1 −1 −1 −1 1 1 −1 1 1 −1 1 −1 |
| | −1 −1 −1 1 −1 −1 1 1 1 −1 −1 1 1 1 1 −1 −1 −1 −1 −1 −1 −1 1 1 1 −1 −1 −1 −1 1 |
| | −1 −1 1 1 1 −1 1 −1 1 1 −1 −1 −1 −1 −1 −1 −1 −1 1 −1 1 −1 1 −1 −1 −1 −1 1 1 1 1 |
| | −1 −1 1 −1 −1 −1 1 1 −1 −1 1 −1 −1 −1 1 1 1 −1 1 1 1 1 −1 1 1 −1 1 1 1 −1 1 −1 |
| | −1 1 −1 −1 −1 −1 −1 1 −1 1 1 −1 1 1 −1 1 −1 1 −1 1 −1 −1 1 1 −1 1 −1 −1 1 1 −1 |
| | −1 −1 −1 1 −1 −1 1 1 1 1 −1 −1 1 −1 −1 −1 −1 −1 −1 −1 −1 −1 −1 −1 1 1 1 −1 1 |
| | −1 1 1 1 1 1 1 1 −1 1 −1 1 −1 1 −1 1 1 −1 1 1 1 −1 −1 1 −1 −1 −1 −1 −1 1 −1 1 −1 |
| | 1 1 1 1 1 −1 1 −1 1 −1 −1 1 −1 −1 1 1 −1 1 −1 −1 1 −1 −1 1 −1 1 −1 −1 −1 1 1 1 1 |
| | −1 1 −1 −1 1 1 −1 1 1 1 1 −1 −1 −1 −1 1 1 −1 −1 1 1 −1 1 −1 −1 1 −1 −1 −1 1 1 |
| | −1 1 −1 1 1 1 1 −1 1 −1 1 1 1 1 1 1 −1 1 1 −1 −1 −1 1 1 −1 1 1 −1 −1 −1 −1 |
| | −1 −1 1 −1 1 1 −1 1 −1 −1 −1 −1 −1 1 1 −1 −1 1 1 −1 1 1 1 1 −1 1 −1 1 1 −1 1 −1 |
| | 1 1 −1 1 −1 −1 −1 1 −1 1 −1 1 1 −1 1 −1 1 1 1 1 1 −1 1 −1 −1 1 −1 1 1 −1 1 1 −1 1 |
| | −1 −1 1 1 −1 1 1 1 −1 1 −1 −1 1 1 1 −1 −1 1 1 −1 1 1 −1 1 1 −1 −1 −1 1 1 1 −1 1 1 |
| | −1 −1 1 −1 −1 −1 −1 1 1 −1 1 −1 −1 −1 −1 1 1 −1 1 −1 −1 1 1 1 1 1 1 −1 −1 1 1 1 |
| | 1 1 −1 −1 −1 −1 1 1 −1 1 1 −1 −1 −1 1 −1 1 −1 −1 −1 1 1 1 −1 −1 −1 −1 1 −1 1 −1 |
| | 1 1 1 1 −1 1 1 −1 −1 −1 −1 1 −1 −1 1 1 |
| 14 | −1 −1 −1 −1 −1 −1 −1 −1 −1 −1 −1 −1 −1 1 −1 1 −1 1 −1 −1 −1 1 1 −1 1 1 −1 −1 |
| | 1 −1 −1 1 1 −1 1 1 −1 1 1 1 −1 −1 −1 −1 −1 −1 −1 1 −1 −1 1 1 1 1 1 1 1 −1 1 1 −1 |
| | 1 −1 1 −1 1 −1 1 −1 1 −1 −1 −1 1 1 −1 −1 −1 1 1 −1 1 −1 1 −1 −1 −1 −1 −1 −1 1 |
| | −1 1 −1 1 −1 1 1 −1 −1 1 −1 1 −1 1 1 1 1 1 −1 −1 −1 −1 −1 −1 1 −1 1 −1 1 1 −1 |
| | −1 1 1 −1 −1 1 1 1 −1 −1 1 −1 −1 1 1 −1 1 −1 −1 1 1 1 −1 1 −1 1 1 1 −1 −1 1 1 −1 |
| | 1 −1 −1 −1 −1 1 1 −1 1 1 1 1 −1 −1 1 −1 1 −1 −1 −1 1 1 −1 1 −1 −1 −1 1 −1 −1 −1 |
| | 1 1 −1 −1 −1 −1 −1 −1 1 −1 1 1 1 1 −1 −1 1 −1 −1 1 −1 −1 1 1 1 −1 1 −1 −1 −1 1 |
| | −1 −1 1 −1 1 −1 −1 −1 1 1 1 1 −1 −1 −1 1 1 −1 1 −1 −1 −1 1 1 1 1 −1 −1 1 −1 −1 |
| | 1 −1 1 −1 −1 −1 1 −1 −1 −1 1 1 1 1 1 1 1 1 1 −1 −1 1 −1 −1 −1 1 1 1 1 1 1 −1 −1 |
| | −1 1 1 −1 −1 −1 1 1 −1 −1 1 −1 1 1 1 −1 −1 1 1 1 −1 −1 −1 −1 −1 −1 −1 1 1 1 −1 |
| | −1 −1 −1 1 1 −1 −1 −1 −1 −1 −1 −1 1 1 1 1 1 −1 −1 1 1 1 1 1 −1 −1 1 1 −1 1 1 |
| | −1 −1 1 −1 −1 −1 −1 1 −1 −1 1 1 1 −1 −1 1 1 −1 1 −1 1 −1 −1 1 1 −1 −1 1 −1 −1 1 |
| | −1 −1 1 −1 1 −1 1 −1 −1 1 1 1 1 −1 −1 −1 1 1 1 1 −1 −1 −1 1 −1 1 −1 1 1 1 1 1 −1 |
| | 1 1 1 1 1 −1 −1 1 1 1 −1 1 −1 −1 1 1 1 1 −1 1 1 1 1 1 1 1 1 1 1 −1 −1 1 1 1 −1 −1 |
| | −1 1 1 −1 −1 1 1 1 −1 −1 1 1 1 −1 −1 1 −1 −1 −1 −1 1 −1 1 1 1 1 −1 −1 −1 1 1 −1 |
| | 1 1 1 1 −1 −1 −1 1 −1 1 1 1 1 1 1 1 1 1 −1 −1 −1 1 1 1 −1 −1 1 1 −1 1 1 1 −1 −1 1 |
| | 1 1 −1 −1 1 1 1 1 1 1 −1 1 1 1 −1 1 1 1 −1 −1 1 1 −1 1 −1 1 1 1 −1 −1 1 1 1 −1 1 1 1 |
| | 1 1 1 1 1 −1 −1 1 1 −1 −1 1 1 1 −1 1 −1 1 1 −1 −1 −1 1 1 −1 −1 −1 1 1 1 1 −1 1 −1 |
| | −1 1 −1 1 1 −1 −1 −1 1 −1 1 1 −1 1 1 −1 −1 −1 1 1 −1 1 −1 −1 −1 −1 −1 −1 −1 1 1 |
| | 1 −1 1 1 1 −1 −1 1 −1 −1 1 −1 1 1 −1 −1 1 −1 −1 1 1 −1 −1 −1 1 −1 −1 −1 −1 −1 1 |
| | −1 1 1 −1 −1 −1 1 −1 1 −1 1 −1 −1 1 1 −1 1 −1 −1 −1 1 −1 1 1 −1 −1 1 −1 1 |
| | 1 −1 −1 −1 −1 −1 −1 −1 1 −1 1 1 1 1 1 1 −1 1 1 −1 −1 −1 −1 1 −1 1 1 1 −1 1 −1 |
| | −1 1 1 1 −1 −1 1 1 1 1 −1 1 −1 −1 −1 1 1 1 −1 −1 1 −1 1 1 1 1 −1 1 −1 −1 1 −1 1 |
| | −1 1 1 1 −1 1 1 1 1 1 −1 1 −1 1 1 −1 1 1 1 −1 1 1 −1 1 1 1 1 −1 −1 1 1 1 −1 −1 −1 |
| | 1 −1 −1 −1 1 1 −1 −1 1 1 1 1 −1 1 1 1 −1 1 1 1 1 1 −1 −1 1 −1 −1 1 −1 1 1 1 1 −1 |
| | 1 1 −1 1 −1 1 −1 −1 1 −1 1 −1 1 −1 −1 −1 1 1 1 −1 −1 1 1 −1 −1 −1 −1 1 1 −1 1 1 |
| | 1 −1 −1 −1 1 −1 1 1 −1 1 −1 −1 −1 −1 1 1 1 1 1 1 1 −1 1 1 1 −1 1 −1 1 −1 −1 1 1 1 |
| | 1 1 −1 −1 1 1 1 −1 −1 1 1 −1 −1 −1 1 −1 −1 1 −1 −1 1 −1 1 −1 −1 1 1 −1 −1 −1 1 |
| | −1 1 −1 −1 −1 1 −1 −1 1 1 1 1 1 1 −1 1 −1 −1 1 −1 −1 1 1 1 1 −1 −1 −1 −1 1 1 1 |
| | −1 −1 1 1 1 −1 1 1 −1 −1 −1 −1 −1 −1 −1 −1 −1 1 1 1 1 −1 1 1 −1 −1 −1 1 1 1 −1 |
| | −1 −1 −1 −1 1 1 1 1 1 −1 1 1 1 1 1 1 1 −1 −1 −1 1 1 −1 1 1 −1 −1 1 1 1 −1 −1 1 −1 |
| | 1 −1 −1 1 −1 1 −1 1 −1 1 1 −1 −1 −1 1 −1 1 −1 −1 1 1 −1 −1 1 1 −1 1 −1 −1 1 1 1 |
| | 1 −1 1 −1 −1 −1 −1 −1 −1 1 1 −1 −1 1 −1 1 −1 1 1 1 −1 −1 1 1 1 1 −1 −1 −1 −1 −1 |
| | 1 1 −1 −1 1 −1 1 1 −1 −1 −1 1 1 1 1 −1 1 1 1 −1 1 −1 −1 −1 −1 1 1 1 −1 1 1 1 −1 1 |
| | −1 1 1 −1 1 1 1 1 −1 −1 1 −1 −1 1 1 1 −1 −1 −1 1 1 −1 1 −1 −1 1 −1 −1 −1 −1 1 |
| | −1 1 1 −1 −1 1 1 1 −1 1 −1 −1 1 −1 −1 −1 1 −1 −1 1 1 −1 1 −1 −1 1 −1 −1 1 −1 1 |
| | −1 1 1 1 −1 −1 −1 −1 −1 −1 1 1 −1 −1 1 1 −1 1 −1 −1 −1 −1 −1 −1 1 −1 −1 −1 1 |
| | −1 1 1 1 −1 −1 1 −1 −1 −1 −1 −1 −1 1 1 1 1 1 −1 1 −1 −1 −1 −1 −1 −1 −1 −1 1 1 |
| | −1 1 1 −1 −1 1 −1 1 −1 −1 1 −1 −1 −1 1 −1 1 1 1 −1 1 −1 1 1 1 1 −1 −1 −1 1 −1 |
| | −1 1 1 1 1 1 −1 1 −1 1 1 −1 −1 −1 −1 1 −1 −1 −1 1 −1 1 −1 1 −1 −1 1 −1 1 −1 1 1 |
| | 1 1 −1 −1 −1 −1 −1 −1 1 1 1 −1 1 1 −1 1 1 −1 1 1 1 −1 −1 1 1 1 1 1 −1 −1 −1 −1 1 |
| | −1 −1 1 −1 1 1 −1 1 1 1 1 −1 −1 −1 1 1 −1 −1 −1 −1 −1 1 1 −1 1 1 1 −1 −1 1 −1 1 |
| | −1 −1 1 1 −1 1 −1 1 −1 1 −1 1 −1 −1 1 1 1 −1 −1 −1 −1 1 1 −1 1 1 1 1 1 1 −1 1 −1 |
| | 1 −1 −1 −1 1 1 −1 −1 1 −1 −1 1 −1 1 1 −1 1 −1 1 1 −1 −1 −1 −1 1 1 1 1 −1 1 −1 |
| | −1 1 1 −1 −1 1 1 1 1 −1 −1 1 1 −1 1 1 −1 1 −1 1 1 1 1 1 −1 1 1 −1 −1 −1 1 1 −1 1 |
| | 1 1 1 1 1 1 −1 1 −1 1 1 −1 1 −1 −1 1 −1 −1 1 1 1 −1 1 1 1 1 −1 1 1 1 −1 −1 −1 1 1 |
| | 1 −1 1 −1 1 −1 1 1 −1 1 1 1 1 −1 1 −1 1 1 −1 −1 1 −1 1 −1 −1 −1 −1 −1 −1 1 −1 |
| | −1 1 −1 1 −1 −1 −1 −1 −1 −1 −1 1 1 −1 1 −1 −1 −1 1 −1 1 1 −1 −1 1 1 −1 −1 1 −1 |
| | −1 1 1 −1 1 −1 1 −1 −1 −1 1 −1 −1 1 −1 1 1 1 1 −1 −1 −1 1 −1 1 −1 −1 −1 −1 −1 |
| | −1 1 1 1 −1 1 −1 1 −1 −1 1 −1 1 1 1 −1 −1 −1 1 −1 1 1 1 −1 1 1 1 1 1 1 −1 1 −1 −1 |
| | 1 1 1 −1 −1 −1 −1 −1 −1 1 −1 −1 −1 1 1 −1 −1 −1 1 1 1 −1 1 −1 1 1 −1 −1 1 −1 −1 |
| | 1 1 1 1 1 −1 1 1 −1 −1 1 1 1 −1 1 1 −1 1 −1 −1 −1 −1 −1 1 −1 −1 −1 −1 1 1 −1 −1 |
| | 1 −1 1 −1 −1 −1 −1 1 1 −1 1 1 −1 −1 1 1 −1 1 1 −1 1 −1 −1 −1 −1 −1 −1 1 1 1 1 |
| | −1 1 −1 1 1 1 −1 −1 1 −1 1 −1 1 1 1 −1 1 −1 −1 −1 −1 1 −1 −1 1 −1 −1 −1 −1 1 1 |
| | 1 −1 1 1 −1 1 −1 1 −1 −1 −1 1 −1 1 −1 1 −1 −1 −1 1 −1 1 −1 −1 1 1 1 −1 1 1 −1 1 |
| | 1 −1 −1 −1 −1 1 1 −1 1 1 −1 1 1 1 −1 1 1 1 1 1 1 1 −1 1 1 −1 −1 1 −1 1 −1 1 1 −1 |
| | −1 −1 1 1 1 −1 −1 1 1 1 −1 −1 −1 1 1 1 1 −1 −1 1 −1 1 −1 1 −1 1 1 −1 1 1 −1 1 −1 |
| | 1 −1 1 −1 −1 1 −1 1 1 1 1 1 1 −1 1 −1 1 1 1 1 −1 −1 1 −1 1 1 −1 −1 1 1 −1 −1 −1 1 |
| | 1 −1 −1 1 1 −1 −1 −1 1 1 1 1 −1 −1 1 1 −1 1 −1 1 −1 1 −1 −1 1 1 −1 −1 −1 −1 −1 |
| | 1 −1 −1 −1 −1 −1 1 −1 −1 1 −1 −1 −1 1 1 1 1 −1 1 −1 −1 −1 1 −1 −1 1 1 −1 1 1 1 |
| | −1 1 1 −1 −1 1 1 1 −1 −1 −1 1 −1 1 1 −1 −1 1 1 1 1 −1 1 1 −1 1 −1 −1 −1 −1 1 −1 |
| | 1 1 1 1 1 1 1 −1 −1 1 1 1 −1 1 1 1 −1 −1 −1 −1 −1 1 −1 1 −1 −1 1 −1 1 −1 −1 −1 1 |
| | 1 −1 −1 1 1 1 −1 1 −1 −1 −1 1 1 1 −1 1 −1 1 −1 −1 −1 1 −1 −1 −1 1 −1 −1 −1 −1 |
| | −1 −1 1 1 1 −1 −1 1 −1 1 1 −1 −1 1 −1 1 1 1 −1 −1 −1 −1 −1 1 1 1 −1 −1 1 −1 −1 |
| | −1 1 1 −1 1 1 1 −1 −1 1 1 −1 1 1 −1 −1 −1 1 1 1 1 −1 −1 −1 −1 1 −1 1 −1 −1 1 1 |
| | −1 −1 −1 −1 1 −1 1 1 1 1 −1 1 1 −1 −1 1 −1 1 1 −1 −1 1 1 1 1 1 −1 −1 1 −1 1 −1 |
| | −1 1 1 1 −1 1 −1 1 −1 −1 1 1 −1 −1 −1 1 1 −1 1 1 1 −1 −1 −1 −1 1 −1 −1 1 −1 −1 |
| | −1 1 −1 −1 −1 1 −1 1 −1 −1 −1 −1 1 −1 1 1 1 −1 −1 −1 −1 1 1 1 1 −1 −1 −1 −1 1 1 |
| | −1 1 1 −1 −1 −1 −1 1 −1 −1 1 1 −1 1 −1 1 1 −1 −1 1 −1 −1 −1 −1 −1 −1 −1 1 1 1 1 |
| | −1 −1 −1 1 1 1 −1 1 1 1 −1 1 1 −1 −1 1 −1 −1 1 1 1 −1 −1 1 −1 −1 1 −1 1 −1 1 1 |
| | −1 1 1 1 1 1 −1 1 −1 −1 1 −1 1 1 1 1 1 −1 1 −1 1 −1 −1 1 1 1 −1 −1 1 1 −1 −1 1 −1 |
| | 1 1 −1 1 −1 1 1 1 1 1 1 −1 −1 1 1 1 1 1 1 1 −1 −1 1 −1 1 −1 1 1 1 1 −1 1 1 1 1 1 −1 |
| | 1 1 1 1 −1 1 1 −1 −1 −1 −1 1 1 −1 −1 −1 1 −1 −1 −1 −1 1 −1 1 −1 −1 1 −1 −1 −1 |
| | −1 −1 1 1 1 −1 −1 −1 −1 −1 −1 1 1 1 1 −1 −1 1 −1 −1 −1 1 −1 1 1 1 1 −1 1 −1 −1 |
| | −1 1 −1 1 −1 −1 1 −1 −1 1 −1 −1 1 1 1 1 −1 1 1 1 −1 −1 −1 −1 −1 −1 1 −1 1 1 −1 |
| | −1 1 1 −1 1 −1 1 1 −1 −1 −1 1 1 1 1 1 −1 −1 −1 1 −1 −1 −1 1 −1 −1 −1 1 1 1 −1 |
| | −1 −1 −1 −1 −1 −1 −1 −1 −1 1 1 1 −1 1 −1 −1 1 1 −1 1 −1 1 1 1 −1 1 −1 −1 −1 1 |
| | −1 1 1 −1 1 −1 −1 1 1 −1 −1 −1 −1 1 1 −1 −1 −1 −1 1 1 1 1 −1 −1 1 1 −1 −1 1 −1 |
| | 1 −1 1 −1 1 −1 −1 1 1 −1 1 1 1 1 −1 1 −1 −1 1 −1 −1 1 −1 −1 −1 1 1 1 −1 1 −1 1 1 |
| | 1 1 −1 1 1 −1 1 1 −1 1 1 −1 1 1 −1 −1 −1 1 1 1 −1 1 1 1 1 −1 −1 1 1 −1 −1 −1 −1 1 |
| | −1 1 −1 −1 −1 1 −1 −1 −1 −1 −1 −1 −1 −1 −1 1 1 −1 −1 1 −1 −1 1 −1 −1 −1 1 −1 |
| | 1 −1 1 −1 1 −1 1 −1 1 −1 1 1 −1 −1 1 1 −1 1 −1 −1 −1 1 1 1 −1 1 1 −1 1 1 1 −1 −1 |
| | −1 1 1 1 1 −1 1 −1 1 −1 1 −1 −1 1 −1 −1 −1 −1 −1 −1 −1 −1 1 1 1 −1 −1 1 1 −1 −1 |
| | 1 1 −1 −1 1 −1 1 1 1 −1 1 −1 −1 −1 1 1 −1 −1 1 −1 1 −1 1 −1 −1 1 1 −1 −1 1 1 1 |
| | −1 1 1 −1 −1 1 1 1 1 1 1 −1 1 −1 1 −1 1 1 −1 −1 1 1 1 −1 1 1 1 −1 1 1 1 1 −1 1 1 |
| | −1 1 1 1 −1 −1 1 −1 −1 −1 −1 1 1 −1 −1 −1 −1 1 −1 −1 −1 1 1 −1 1 −1 1 1 1 −1 −1 |
| | −1 −1 −1 1 −1 −1 1 1 −1 1 −1 −1 −1 1 1 −1 1 −1 −1 1 −1 1 1 1 −1 1 −1 1 −1 1 1 |
| | −1 −1 −1 −1 −1 1 −1 −1 1 −1 −1 1 −1 −1 −1 −1 1 1 −1 1 −1 −1 1 −1 −1 1 1 −1 1 |
| | −1 −1 −1 −1 −1 1 −1 1 1 1 −1 −1 1 −1 1 1 1 1 1 −1 1 1 −1 1 1 −1 −1 1 −1 1 1 −1 1 |
| | −1 −1 −1 −1 −1 −1 −1 −1 −1 −1 1 −1 −1 1 −1 1 1 1 1 1 1 1 −1 1 −1 −1 −1 1 −1 1 1 |
| | 1 −1 1 1 −1 −1 −1 −1 1 −1 −1 −1 −1 1 −1 1 −1 1 −1 1 1 1 1 −1 1 −1 1 1 1 −1 1 −1 |
| | 1 −1 1 −1 1 1 1 1 1 1 −1 1 1 1 1 1 1 −1 1 1 1 −1 −1 −1 1 −1 −1 1 −1 1 −1 −1 1 −1 |
| | −1 −1 −1 1 −1 −1 −1 1 1 −1 −1 1 −1 −1 −1 1 −1 −1 1 −1 −1 1 −1 −1 1 1 −1 −1 1 |
| | −1 −1 −1 −1 −1 1 1 1 1 1 −1 1 −1 −1 1 1 −1 −1 −1 −1 −1 −1 1 1 1 1 1 1 −1 1 |
| | 1 1 1 −1 −1 1 −1 −1 −1 −1 −1 1 1 1 1 1 1 1 1 1 1 1 −1 1 1 1 1 1 −1 1 −1 −1 −1 1 |
| | −1 −1 −1 −1 1 −1 −1 −1 −1 1 −1 −1 1 −1 1 −1 −1 1 1 1 1 1 −1 1 −1 −1 −1 1 1 1 1 |
| | 1 −1 1 −1 −1 1 1 1 1 1 1 1 1 1 1 −1 1 −1 −1 −1 −1 1 −1 −1 −1 1 1 1 1 −1 1 1 1 1 |
| | −1 1 1 1 1 1 1 −1 −1 −1 −1 1 1 1 1 −1 1 1 1 −1 −1 1 1 1 1 −1 1 1 1 1 −1 −1 −1 −1 |
| | −1 −1 −1 −1 −1 1 −1 −1 −1 1 −1 −1 −1 −1 1 1 −1 −1 −1 1 −1 1 1 1 −1 1 −1 −1 −1 |
| | −1 −1 1 1 −1 1 1 −1 −1 −1 1 −1 1 1 −1 −1 −1 1 1 1 −1 1 −1 −1 −1 1 1 −1 1 −1 1 |
| | −1 1 −1 −1 −1 −1 1 1 1 1 −1 1 1 −1 1 1 −1 −1 −1 1 −1 −1 1 −1 −1 −1 1 −1 1 1 −1 |
| | 1 −1 1 −1 −1 1 1 1 −1 1 −1 −1 1 1 −1 −1 1 −1 −1 −1 1 1 −1 1 −1 −1 1 1 −1 −1 −1 |
| | 1 −1 −1 1 1 1 −1 1 −1 1 −1 1 −1 −1 1 1 1 1 1 1 1 −1 −1 −1 1 −1 1 −1 −1 1 1 1 1 −1 |
| | −1 1 −1 −1 −1 −1 1 −1 −1 −1 −1 −1 1 1 −1 1 −1 −1 −1 −1 1 −1 −1 1 1 1 1 1 −1 −1 |
| | 1 −1 −1 1 1 −1 −1 −1 −1 1 1 1 1 1 1 −1 −1 1 1 1 −1 −1 −1 −1 1 1 1 −1 −1 −1 −1 |
| | −1 1 −1 −1 −1 −1 1 −1 1 1 −1 1 −1 −1 −1 1 −1 −1 −1 −1 −1 1 1 1 1 −1 −1 −1 −1 |
| | −1 −1 1 −1 −1 1 −1 −1 1 1 1 1 1 −1 −1 −1 1 1 −1 −1 1 −1 −1 1 1 −1 −1 1 −1 1 1 1 |
| | 1 −1 1 1 1 −1 1 −1 1 1 1 −1 −1 −1 −1 1 −1 1 1 −1 −1 −1 1 1 −1 1 −1 1 1 1 1 1 1 1 |
| | 1 −1 −1 −1 −1 1 1 −1 −1 1 −1 −1 −1 −1 −1 −1 1 −1 −1 −1 −1 1 −1 −1 −1 1 −1 1 1 |
| | −1 1 1 −1 1 1 −1 −1 1 −1 −1 −1 1 −1 1 1 −1 −1 1 −1 1 1 −1 1 1 1 1 1 1 1 −1 −1 1 |
| | −1 −1 1 −1 −1 −1 −1 −1 1 −1 1 −1 −1 −1 −1 1 −1 −1 −1 −1 1 1 1 −1 1 −1 1 −1 1 |
| | −1 1 −1 −1 −1 −1 −1 1 1 1 −1 1 −1 −1 −1 −1 1 −1 1 −1 1 1 1 1 1 1 −1 −1 −1 −1 −1 |
| | −1 −1 −1 1 −1 1 1 1 −1 −1 −1 1 −1 −1 −1 −1 1 −1 −1 1 1 −1 1 1 −1 −1 1 1 −1 −1 |
| | −1 1 −1 1 1 −1 −1 1 −1 −1 −1 1 −1 −1 −1 1 1 −1 1 1 1 1 1 −1 −1 1 −1 1 −1 1 −1 |
| | −1 −1 1 −1 −1 1 1 −1 −1 −1 −1 1 −1 −1 −1 −1 −1 1 −1 1 −1 1 1 1 −1 1 1 −1 −1 −1 |
| | 1 −1 1 1 1 1 1 −1 −1 −1 −1 1 1 −1 1 −1 1 1 1 1 −1 −1 −1 −1 1 1 −1 −1 −1 1 1 1 1 1 |
| | −1 1 1 −1 1 1 1 1 −1 1 −1 −1 −1 1 1 −1 1 1 −1 1 −1 1 1 −1 −1 −1 1 −1 −1 −1 −1 1 |
| | 1 −1 1 1 −1 1 −1 −1 1 −1 −1 −1 1 1 −1 1 1 −1 1 1 −1 −1 1 1 1 1 −1 1 −1 1 −1 1 1 1 |
| | −1 1 1 1 −1 −1 1 −1 1 −1 1 −1 −1 1 −1 1 1 −1 −1 −1 −1 1 −1 −1 1 −1 1 −1 1 −1 −1 |
| | −1 −1 −1 −1 1 1 −1 1 −1 1 −1 1 −1 1 1 1 −1 −1 −1 1 −1 −1 1 1 −1 1 1 −1 1 −1 −1 |
| | 1 1 1 1 −1 −1 1 1 1 1 1 −1 1 −1 −1 1 −1 −1 −1 −1 −1 −1 1 1 −1 −1 −1 1 −1 1 −1 |
| | −1 1 −1 1 1 −1 −1 1 1 −1 1 1 −1 −1 1 1 1 1 1 −1 1 −1 1 −1 1 1 1 1 −1 −1 −1 1 1 1 |
| | −1 −1 −1 −1 1 −1 −1 −1 −1 −1 −1 1 −1 1 −1 −1 1 −1 −1 1 1 1 −1 −1 −1 −1 −1 1 |
| | −1 1 1 1 −1 1 −1 1 −1 −1 −1 1 1 1 1 −1 1 1 −1 −1 1 −1 −1 −1 1 1 −1 −1 1 1 −1 −1 |
| | 1 −1 −1 −1 −1 1 −1 1 −1 −1 −1 1 1 1 1 1 1 1 −1 −1 1 1 −1 1 −1 −1 −1 1 −1 −1 1 |
| | −1 −1 1 1 1 −1 −1 1 1 1 −1 1 −1 1 1 1 1 1 −1 −1 1 −1 −1 −1 1 −1 −1 −1 −1 −1 1 |
| | −1 −1 −1 1 1 1 −1 −1 1 1 1 1 1 1 −1 −1 −1 1 −1 1 1 1 −1 −1 −1 −1 −1 −1 −1 −1 1 |
| | 1 −1 −1 −1 1 1 −1 1 1 −1 1 1 1 1 −1 −1 −1 −1 −1 1 1 1 1 −1 1 −1 −1 −1 −1 1 1 −1 |
| | −1 1 1 1 −1 −1 −1 −1 −1 1 1 −1 −1 −1 1 −1 −1 1 1 −1 1 −1 1 −1 1 1 −1 1 1 −1 −1 |
| | 1 −1 1 −1 1 −1 1 1 1 −1 −1 1 −1 1 1 −1 −1 −1 1 −1 −1 −1 1 −1 −1 1 −1 −1 −1 1 1 |
| | −1 −1 1 −1 1 1 −1 1 1 −1 −1 −1 −1 −1 1 −1 1 1 −1 −1 1 −1 1 −1 1 −1 −1 −1 −1 1 1 |
| | −1 −1 1 −1 −1 1 1 1 1 −1 1 −1 −1 1 1 1 1 −1 −1 −1 −1 −1 −1 −1 1 1 −1 1 1 1 1 −1 |
| | 1 −1 1 −1 1 1 −1 1 −1 −1 −1 1 −1 1 1 1 1 −1 −1 1 1 1 −1 1 1 −1 1 1 1 1 1 1 −1 −1 |
| | −1 1 −1 −1 −1 −1 1 1 1 −1 −1 1 −1 1 −1 1 1 −1 1 −1 1 1 1 −1 1 1 −1 −1 1 −1 1 −1 |
| | −1 −1 1 1 1 −1 1 1 1 −1 −1 −1 1 1 −1 1 −1 1 −1 1 1 1 1 1 −1 −1 1 1 1 1 −1 1 1 −1 |
| | −1 1 1 1 1 −1 −1 1 −1 1 −1 −1 1 −1 −1 1 −1 1 −1 −1 −1 −1 1 1 1 −1 −1 1 1 −1 1 |
| | −1 −1 1 1 −1 −1 1 −1 1 1 −1 −1 1 −1 −1 −1 −1 1 1 1 −1 −1 −1 1 −1 1 −1 −1 −1 1 1 |
| | 1 −1 −1 −1 −1 1 1 1 1 1 1 1 1 −1 −1 −1 1 −1 −1 1 1 −1 −1 −1 1 −1 1 1 1 1 −1 1 1 1 |
| | 1 −1 1 −1 −1 −1 −1 −1 1 −1 −1 1 1 −1 −1 1 1 1 −1 −1 −1 1 1 −1 −1 1 1 −1 1 1 −1 |
| | −1 −1 −1 −1 −1 −1 1 1 −1 −1 −1 −1 −1 1 −1 −1 1 1 1 −1 1 1 1 −1 1 −1 −1 −1 1 −1 |
| | −1 −1 1 −1 1 1 1 1 1 −1 1 1 1 −1 −1 1 1 −1 −1 1 −1 −1 −1 1 −1 1 −1 1 1 −1 1 −1 1 |
| | −1 −1 1 −1 −1 1 −1 1 1 1 1 1 −1 −1 1 −1 1 1 −1 1 1 1 −1 −1 −1 −1 1 1 1 −1 1 1 1 1 |
| | −1 1 −1 −1 1 1 1 −1 1 1 1 1 1 −1 −1 −1 1 1 −1 1 −1 1 1 −1 −1 −1 −1 −1 −1 −1 −1 |
| | 1 −1 −1 −1 −1 1 1 1 1 −1 1 −1 1 −1 −1 1 1 −1 1 1 −1 −1 1 −1 1 1 1 −1 1 1 1 1 −1 |
| | −1 1 −1 1 1 1 1 −1 −1 1 1 −1 1 −1 −1 1 −1 1 1 −1 1 −1 1 −1 1 1 1 1 −1 1 1 −1 −1 |
| | −1 1 −1 −1 1 1 1 1 −1 1 −1 1 −1 −1 −1 −1 1 −1 −1 1 −1 1 1 1 −1 −1 −1 −1 1 −1 −1 |
| | −1 1 1 1 −1 1 −1 −1 −1 −1 −1 1 −1 1 −1 −1 1 1 −1 1 1 1 −1 1 −1 1 1 −1 −1 −1 −1 |
| | −1 1 1 1 −1 1 1 −1 −1 −1 1 −1 −1 −1 −1 −1 −1 1 −1 −1 1 1 −1 1 1 1 1 −1 −1 1 1 |
| | −1 1 1 1 −1 1 −1 −1 −1 1 1 1 1 −1 1 −1 1 1 −1 1 1 −1 1 −1 −1 1 −1 1 1 −1 −1 1 −1 |
| | 1 −1 −1 1 1 1 1 −1 1 −1 1 1 1 1 1 −1 1 −1 1 1 1 −1 −1 −1 1 −1 1 −1 −1 1 −1 −1 −1 |
| | 1 1 −1 −1 −1 1 −1 −1 1 −1 1 −1 1 −1 1 1 1 1 1 −1 1 −1 −1 −1 −1 1 1 1 1 −1 −1 −1 |
| | 1 −1 −1 1 −1 −1 −1 −1 1 −1 −1 1 −1 −1 1 1 −1 −1 −1 1 1 1 1 1 1 −1 −1 1 −1 −1 1 |
| | 1 1 1 1 1 −1 −1 1 1 −1 1 1 1 1 −1 1 1 1 −1 1 1 −1 −1 −1 1 1 −1 −1 −1 −1 −1 −1 −1 |
| | 1 −1 −1 −1 −1 −1 −1 −1 −1 1 −1 −1 1 1 −1 −1 −1 −1 −1 1 1 1 1 1 1 −1 −1 −1 −1 |
| | −1 1 1 1 −1 1 −1 1 1 1 −1 1 −1 −1 1 −1 1 −1 −1 1 1 −1 1 1 −1 1 −1 1 −1 −1 −1 −1 |
| | 1 −1 1 −1 1 −1 −1 −1 −1 −1 1 −1 −1 1 −1 1 1 −1 −1 −1 −1 −1 1 1 −1 1 −1 −1 1 1 |
| | −1 1 1 −1 1 1 −1 1 1 1 1 1 −1 −1 −1 −1 1 −1 1 −1 1 −1 −1 1 1 1 −1 1 1 1 −1 −1 1 1 |
| | 1 −1 1 −1 −1 −1 −1 −1 −1 1 −1 1 1 −1 1 −1 −1 1 −1 1 1 1 1 −1 1 −1 1 −1 1 −1 1 |
| | −1 1 1 1 1 −1 −1 1 −1 −1 −1 1 1 −1 −1 −1 −1 1 1 −1 1 −1 −1 1 1 1 −1 −1 1 −1 −1 |
| | −1 1 −1 1 −1 −1 −1 1 −1 1 −1 −1 −1 −1 −1 1 −1 −1 −1 1 −1 −1 1 1 −1 −1 1 1 −1 1 |
| | 1 1 −1 −1 −1 −1 −1 1 1 −1 1 1 −1 1 1 −1 1 −1 −1 −1 −1 1 1 −1 −1 −1 −1 −1 1 1 1 |
| | −1 −1 −1 1 1 1 −1 −1 −1 1 −1 1 1 1 1 −1 −1 −1 −1 −1 1 −1 −1 −1 1 −1 1 −1 −1 1 1 |
| | −1 1 −1 −1 1 −1 1 −1 1 −1 1 −1 1 1 1 −1 1 1 −1 1 1 −1 1 −1 −1 1 1 −1 −1 1 1 −1 |
| | −1 1 1 −1 −1 −1 1 −1 −1 −1 1 1 −1 1 −1 −1 −1 −1 1 1 1 −1 −1 −1 −1 1 −1 1 1 1 1 |
| | 1 −1 −1 1 1 −1 −1 1 −1 −1 1 −1 1 −1 1 −1 1 −1 −1 −1 −1 1 −1 −1 −1 1 −1 −1 −1 1 |
| | −1 −1 1 1 1 1 −1 −1 1 −1 1 1 1 −1 1 1 −1 −1 1 1 −1 1 1 1 −1 1 1 1 1 −1 −1 −1 1 −1 |
| | −1 −1 −1 −1 −1 −1 1 1 −1 −1 1 1 1 −1 1 1 1 1 −1 −1 −1 −1 1 1 1 1 1 −1 −1 −1 1 1 |
| | 1 1 −1 1 1 −1 1 −1 1 1 1 −1 1 −1 1 1 −1 1 −1 −1 −1 1 1 −1 −1 −1 −1 1 −1 1 −1 1 1 |
| | −1 1 1 1 −1 −1 1 −1 1 1 1 −1 −1 1 1 1 1 −1 −1 1 1 −1 −1 −1 1 −1 1 −1 1 1 |
| | −1 1 1 −1 1 1 −1 1 −1 1 1 1 −1 −1 1 −1 −1 1 −1 −1 −1 1 1 −1 1 −1 1 −1 −1 1 1 1 1 |
| | −1 1 1 −1 −1 −1 −1 −1 −1 1 1 1 −1 −1 −1 1 −1 −1 1 1 1 −1 −1 1 −1 1 −1 1 −1 1 −1 |
| | 1 −1 −1 1 −1 −1 1 1 1 1 1 1 −1 −1 1 −1 1 1 −1 −1 −1 −1 1 1 1 −1 1 −1 1 1 −1 1 |
| | −1 1 1 −1 −1 1 1 −1 −1 −1 −1 −1 1 1 −1 −1 −1 −1 1 1 −1 −1 1 1 −1 −1 −1 −1 −1 |
| | −1 −1 1 1 1 1 1 1 1 −1 −1 −1 −1 1 −1 1 1 −1 1 1 −1 −1 1 −1 −1 1 −1 1 −1 −1 1 −1 |
| | 1 1 1 −1 1 1 −1 1 −1 −1 1 −1 −1 1 −1 −1 1 −1 −1 −1 1 −1 −1 1 −1 1 −1 1 1 −1 −1 |
| | −1 −1 −1 −1 1 1 −1 1 1 1 −1 1 −1 1 −1 1 1 1 1 1 1 1 −1 −1 −1 −1 −1 1 −1 −1 1 −1 |
| | 1 −1 1 1 1 1 1 1 1 1 1 1 1 1 −1 −1 −1 −1 −1 −1 1 1 −1 1 −1 −1 1 −1 1 −1 −1 1 −1 1 |
| | −1 −1 1 −1 −1 1 1 −1 1 1 1 1 1 1 −1 −1 1 −1 1 1 1 1 1 1 −1 −1 1 −1 −1 −1 −1 −1 |
| | −1 −1 −1 −1 −1 −1 1 1 −1 1 −1 1 1 −1 1 −1 −1 −1 −1 −1 1 1 1 1 1 −1 −1 −1 −1 −1 |
| | −1 −1 1 −1 1 −1 −1 −1 −1 −1 1 1 1 1 −1 1 1 1 1 1 −1 −1 −1 −1 −1 1 −1 1 −1 1 −1 |
| | 1 −1 1 1 −1 1 −1 −1 1 −1 1 −1 −1 −1 1 −1 1 1 −1 −1 −1 −1 1 1 −1 1 −1 1 −1 −1 −1 |
| | 1 1 1 −1 1 −1 −1 1 1 1 −1 1 −1 −1 −1 −1 1 1 −1 1 −1 −1 −1 1 1 −1 −1 1 1 −1 1 −1 |
| | 1 1 1 1 1 −1 −1 −1 1 1 1 −1 1 −1 −1 1 −1 −1 1 −1 1 1 −1 −1 −1 1 1 −1 −1 1 −1 −1 |
| | −1 −1 1 1 −1 1 1 1 −1 1 1 −1 1 −1 −1 −1 1 1 −1 1 1 1 −1 1 −1 −1 1 −1 −1 −1 −1 1 |
| | 1 −1 −1 1 1 −1 1 1 1 1 1 1 1 1 −1 1 −1 −1 1 1 −1 1 1 1 1 1 −1 1 1 −1 1 −1 1 1 −1 1 |
| | −1 1 −1 −1 −1 1 1 −1 1 −1 1 1 −1 1 1 1 1 1 1 −1 1 1 −1 1 1 1 −1 1 −1 1 1 1 1 1 1 1 |
| | −1 1 1 1 1 −1 1 −1 1 1 1 1 −1 1 −1 1 −1 −1 1 −1 1 −1 −1 1 1 1 −1 −1 1 −1 1 1 −1 1 |
| | −1 1 −1 −1 −1 −1 −1 1 −1 1 −1 1 −1 −1 1 −1 −1 1 −1 −1 −1 −1 −1 −1 1 −1 1 1 1 |
| | −1 1 1 −1 1 1 1 −1 1 1 −1 −1 −1 −1 −1 1 1 1 1 −1 −1 1 1 1 1 −1 1 −1 1 1 −1 −1 −1 |
| | 1 −1 1 1 1 −1 −1 1 1 1 1 1 1 1 1 1 −1 1 −1 1 1 1 −1 1 1 −1 1 −1 1 −1 1 1 −1 1 −1 1 |
| | 1 −1 1 −1 −1 1 1 1 −1 −1 −1 1 1 1 −1 1 1 −1 1 −1 −1 1 1 1 −1 1 1 −1 −1 −1 1 1 1 1 |
| | 1 1 1 1 −1 1 1 −1 1 1 −1 1 −1 1 −1 −1 1 1 −1 1 −1 1 1 −1 1 −1 1 1 1 1 −1 −1 1 1 |
| | −1 −1 1 1 −1 1 −1 1 −1 −1 −1 −1 1 1 −1 1 −1 1 1 −1 −1 1 1 1 1 1 1 1 −1 1 −1 1 −1 |
| | 1 −1 1 1 −1 −1 −1 −1 1 −1 1 1 −1 1 −1 1 1 −1 1 1 1 −1 −1 −1 1 −1 −1 −1 1 −1 1 1 |
| | −1 −1 −1 1 −1 −1 1 −1 1 1 −1 1 −1 −1 −1 1 1 1 1 1 1 −1 1 1 −1 −1 1 1 −1 1 −1 −1 |
| | 1 −1 −1 −1 1 −1 1 −1 −1 1 −1 1 −1 1 1 −1 −1 1 1 1 1 −1 −1 −1 1 −1 1 1 −1 −1 −1 |
| | −1 −1 −1 1 −1 1 −1 −1 −1 1 1 −1 −1 −1 −1 −1 1 −1 1 −1 −1 −1 1 −1 1 1 1 1 1 1 −1 |
| | −1 −1 1 1 1 1 1 −1 −1 1 −1 1 1 1 −1 −1 −1 1 1 −1 −1 −1 1 −1 1 1 −1 1 −1 1 1 1 −1 |
| | −1 −1 1 1 −1 1 1 −1 1 −1 −1 −1 1 1 1 −1 −1 −1 1 −1 −1 −1 −1 −1 1 1 −1 −1 1 1 1 |
| | 1 −1 −1 −1 −1 1 −1 −1 1 1 −1 −1 1 −1 −1 1 1 1 −1 1 −1 1 1 −1 1 1 −1 −1 1 1 −1 1 |
| | −1 1 −1 1 1 1 −1 −1 1 1 −1 −1 1 1 1 1 −1 1 −1 −1 1 −1 −1 −1 1 1 1 −1 −1 1 −1 −1 |
| | −1 −1 −1 1 −1 −1 −1 −1 −1 −1 1 1 −1 1 1 −1 1 −1 1 −1 1 1 1 −1 1 −1 −1 1 1 −1 1 |
| | 1 −1 −1 −1 1 −1 −1 −1 1 1 1 −1 1 1 1 1 1 1 −1 −1 1 1 −1 −1 −1 −1 −1 1 −1 1 1 1 1 |
| | −1 1 −1 1 1 −1 1 −1 1 −1 1 1 −1 −1 1 −1 −1 1 −1 −1 −1 −1 1 −1 1 −1 1 1 −1 −1 −1 |
| | −1 1 1 −1 −1 1 −1 1 1 1 1 1 −1 −1 −1 1 −1 −1 1 −1 1 1 1 −1 1 1 1 −1 1 1 −1 1 −1 1 |
| | 1 −1 −1 1 −1 1 1 1 1 1 1 1 1 −1 1 1 1 −1 −1 1 −1 1 1 −1 1 1 −1 1 1 1 1 −1 1 1 1 1 |
| | −1 −1 1 1 1 1 1 1 −1 1 1 −1 1 −1 −1 1 −1 1 −1 1 1 −1 1 −1 −1 −1 −1 1 −1 −1 −1 |
| | −1 −1 −1 −1 1 −1 1 1 −1 −1 −1 −1 1 −1 1 −1 1 −1 1 −1 −1 −1 1 −1 1 1 1 −1 −1 −1 |
| | 1 1 1 1 1 −1 1 −1 1 −1 −1 −1 −1 −1 1 1 −1 1 −1 1 1 1 −1 1 1 1 1 −1 1 −1 1 −1 −1 |
| | −1 1 −1 1 1 −1 1 1 1 −1 −1 1 1 −1 −1 −1 1 1 1 −1 1 1 −1 −1 1 1 −1 −1 −1 −1 1 −1 |
| | −1 1 1 1 −1 1 −1 −1 1 −1 1 1 −1 1 1 −1 1 −1 −1 −1 1 −1 −1 1 1 1 −1 −1 −1 1 −1 1 |
| | −1 1 1 −1 −1 −1 1 −1 −1 1 1 −1 −1 1 −1 1 −1 −1 −1 1 −1 −1 1 −1 −1 −1 −1 −1 1 1 |
| | −1 1 1 1 1 1 −1 1 −1 1 −1 1 −1 −1 −1 1 1 1 1 1 −1 −1 1 1 −1 −1 −1 1 1 −1 1 −1 −1 |
| | 1 1 1 1 1 −1 1 1 1 1 −1 −1 −1 1 1 1 1 1 1 1 −1 1 −1 −1 1 −1 1 −1 −1 −1 −1 1 −1 −1 |
| | 1 1 −1 −1 −1 1 1 −1 −1 −1 −1 1 1 1 −1 1 1 −1 −1 1 −1 1 1 1 1 −1 −1 −1 −1 1 −1 1 |
| | 1 1 −1 −1 1 1 −1 −1 −1 −1 −1 −1 1 −1 −1 −1 −1 −1 1 1 1 −1 1 1 1 1 1 −1 1 1 −1 |
| | −1 1 −1 −1 1 −1 −1 1 1 −1 1 −1 1 1 1 1 −1 1 1 1 −1 −1 1 −1 −1 −1 1 −1 −1 1 1 1 |
| | −1 1 1 −1 1 −1 1 1 1 1 −1 1 −1 −1 1 1 −1 1 −1 −1 −1 −1 1 −1 1 −1 −1 −1 −1 −1 −1 |
| | −1 −1 −1 1 −1 1 1 −1 1 1 1 −1 1 −1 −1 1 1 1 1 1 −1 −1 −1 −1 −1 1 1 −1 1 −1 1 −1 |
| | −1 1 −1 −1 −1 1 −1 −1 −1 −1 1 −1 1 1 1 −1 1 1 1 −1 −1 −1 1 −1 1 −1 1 −1 1 1 1 |
| | −1 1 −1 1 −1 −1 1 −1 −1 −1 −1 1 1 1 1 −1 −1 1 −1 1 1 −1 1 −1 −1 1 1 1 1 1 1 −1 |
| | −1 −1 −1 1 −1 −1 −1 1 −1 −1 1 −1 1 1 −1 −1 1 1 1 −1 −1 1 1 −1 1 1 −1 1 1 −1 −1 |
| | −1 −1 −1 −1 1 −1 −1 1 1 1 −1 −1 −1 −1 1 −1 1 −1 −1 −1 −1 1 1 1 1 1 −1 −1 1 −1 |
| | −1 −1 −1 1 1 1 1 1 1 −1 1 −1 −1 −1 1 1 −1 −1 −1 1 −1 1 −1 1 −1 1 −1 −1 1 −1 1 |
| | −1 −1 −1 −1 −1 1 1 −1 −1 1 −1 −1 −1 1 1 1 −1 1 1 −1 −1 −1 −1 1 1 1 1 1 −1 1 1 |
| | −1 −1 −1 −1 −1 1 −1 −1 −1 1 1 −1 1 1 −1 −1 −1 1 1 −1 −1 1 1 1 1 1 −1 −1 −1 1 −1 |
| | 1 1 −1 1 1 1 1 1 −1 −1 1 1 −1 1 −1 1 1 −1 1 1 −1 −1 −1 −1 1 −1 1 −1 −1 1 −1 1 1 1 |
| | 1 −1 −1 1 −1 1 −1 1 1 −1 −1 1 −1 −1 −1 1 1 1 1 −1 −1 1 1 1 −1 1 −1 1 −1 −1 −1 |
| | −1 1 1 1 −1 1 −1 −1 1 −1 1 −1 1 −1 −1 1 −1 −1 −1 1 1 1 1 1 −1 1 1 1 −1 −1 −1 −1 |
| | 1 1 −1 1 −1 −1 −1 −1 −1 1 1 −1 −1 −1 1 1 1 −1 −1 1 −1 −1 1 1 1 −1 1 1 −1 −1 1 |
| | −1 −1 −1 −1 −1 1 1 −1 −1 −1 −1 −1 −1 1 1 −1 −1 −1 −1 1 −1 1 1 −1 −1 1 −1 −1 1 |
| | −1 1 1 1 −1 1 −1 −1 1 −1 −1 1 1 −1 −1 1 1 1 1 1 1 −1 −1 1 −1 1 −1 −1 −1 −1 −1 1 |
| | −1 1 1 −1 1 1 −1 1 −1 1 1 −1 1 1 −1 1 1 1 −1 1 −1 −1 −1 −1 −1 −1 −1 1 −1 −1 1 |
| | −1 −1 −1 −1 −1 −1 −1 1 −1 −1 −1 1 1 1 1 1 −1 −1 −1 −1 1 1 1 −1 1 −1 −1 −1 1 −1 |
| | 1 −1 1 −1 1 1 −1 1 −1 1 −1 1 −1 1 1 −1 1 1 1 −1 1 −1 1 −1 −1 −1 −1 −1 −1 −1 1 |
| | −1 1 −1 1 1 1 1 −1 −1 1 1 1 1 −1 −1 1 −1 −1 1 1 −1 1 1 1 −1 −1 −1 1 1 −1 −1 1 −1 |
| | 1 −1 −1 1 1 −1 −1 1 −1 1 −1 1 1 −1 1 1 −1 −1 −1 1 −1 1 −1 1 1 1 −1 −1 1 −1 −1 |
| | −1 1 1 1 −1 −1 −1 1 1 1 1 1 1 −1 1 −1 1 1 −1 −1 1 1 −1 1 1 1 1 −1 −1 −1 −1 1 −1 |
| | −1 −1 −1 1 1 −1 1 −1 1 −1 1 1 −1 −1 −1 1 1 −1 1 1 −1 −1 −1 −1 −1 1 1 −1 −1 1 1 |
| | −1 −1 1 1 1 1 1 −1 1 1 −1 1 −1 −1 −1 1 −1 1 −1 −1 −1 1 1 −1 1 1 1 1 −1 1 1 −1 1 |
| | −1 −1 1 1 −1 1 −1 −1 1 1 −1 1 −1 1 −1 −1 1 −1 1 1 −1 1 1 1 −1 1 1 1 −1 −1 −1 −1 |
| | 1 −1 1 −1 1 1 1 −1 −1 −1 1 1 1 −1 −1 1 −1 1 −1 −1 −1 1 −1 1 −1 1 1 1 1 −1 1 −1 |
| | −1 −1 −1 1 −1 1 1 −1 −1 −1 −1 −1 1 −1 1 −1 1 1 −1 1 −1 −1 1 1 −1 1 1 1 −1 −1 1 |
| | −1 −1 1 1 −1 −1 1 1 −1 −1 −1 −1 1 1 1 −1 −1 −1 1 1 −1 1 1 1 −1 1 1 1 −1 1 1 1 −1 |
| | 1 −1 −1 1 −1 1 1 1 −1 −1 1 −1 1 −1 −1 −1 −1 1 −1 1 −1 −1 1 1 1 1 1 1 −1 1 1 1 −1 |
| | 1 1 −1 1 1 −1 −1 1 1 −1 −1 1 −1 1 −1 −1 1 −1 1 1 −1 1 −1 −1 1 −1 −1 −1 −1 −1 1 |
| | −1 −1 1 1 1 1 −1 −1 −1 1 −1 −1 −1 1 1 1 1 −1 −1 −1 −1 −1 1 −1 1 1 −1 1 −1 1 −1 |
| | 1 −1 −1 −1 1 −1 −1 −1 −1 1 1 1 1 1 −1 1 −1 1 1 1 1 1 1 −1 1 −1 −1 −1 −1 −1 1 1 1 |
| | −1 −1 1 1 1 1 −1 −1 1 1 1 −1 −1 1 −1 1 1 1 −1 1 −1 1 1 −1 −1 1 1 1 −1 −1 −1 −1 1 |
| | −1 −1 1 1 1 1 −1 1 1 −1 1 1 1 1 1 −1 1 1 1 −1 1 −1 −1 1 1 −1 −1 −1 1 1 1 −1 −1 −1 |
| | 1 1 −1 −1 −1 −1 1 −1 −1 1 −1 −1 1 −1 1 1 1 −1 −1 1 1 −1 1 1 1 1 1 −1 −1 −1 1 −1 |
| | 1 −1 1 −1 −1 −1 −1 1 −1 1 1 −1 1 1 1 1 −1 1 1 −1 −1 1 1 −1 −1 1 1 −1 1 1 −1 1 1 1 |
| | 1 1 1 1 1 1 −1 1 1 −1 −1 −1 1 −1 1 −1 −1 −1 −1 1 1 −1 −1 −1 1 1 −1 −1 −1 1 −1 |
| | −1 −1 1 −1 −1 1 1 1 −1 1 −1 1 1 1 −1 1 1 1 −1 1 −1 1 −1 1 −1 −1 −1 −1 −1 −1 |
| | −1 −1 1 −1 1 −1 −1 1 1 1 −1 −1 −1 1 −1 −1 1 −1 −1 1 1 −1 1 1 −1 −1 −1 −1 1 1 1 |
| | −1 −1 1 −1 −1 1 −1 −1 1 −1 −1 1 −1 1 1 −1 1 1 −1 −1 1 1 1 −1 1 −1 1 −1 1 1 1 −1 |
| | −1 −1 −1 1 1 −1 −1 1 1 1 1 1 1 1 1 −1 1 −1 1 −1 −1 1 −1 −1 1 1 |
| 15 | −1 −1 −1 −1 −1 −1 −1 −1 −1 −1 −1 −1 −1 1 1 1 −1 −1 1 −1 1 1 1 −1 −1 1 −1 1 −1 |
| | −1 −1 −1 −1 1 −1 −1 −1 1 −1 1 −1 1 −1 1 1 1 −1 −1 −1 −1 −1 −1 1 −1 −1 1 1 1 1 1 |
| | 1 −1 −1 1 −1 1 1 −1 −1 1 1 −1 1 −1 −1 −1 −1 −1 1 −1 −1 −1 −1 −1 1 1 1 1 −1 −1 1 |
| | −1 1 −1 1 1 1 −1 −1 −1 1 1 −1 −1 1 1 1 1 −1 1 −1 −1 1 −1 1 −1 −1 1 −1 −1 −1 1 1 |
| | 1 1 −1 −1 −1 −1 1 −1 1 −1 1 1 1 1 1 1 1 −1 −1 1 −1 −1 1 1 1 1 1 1 1 1 1 1 −1 −1 |
| | −1 −1 −1 1 1 −1 1 −1 −1 −1 1 1 −1 −1 1 −1 1 1 −1 1 1 −1 −1 1 −1 −1 −1 −1 −1 1 |
| | −1 −1 −1 −1 1 1 1 −1 1 1 1 −1 −1 1 1 1 −1 −1 1 1 −1 1 1 −1 1 −1 1 1 −1 1 −1 1 1 |
| | −1 1 1 −1 1 1 −1 −1 −1 1 −1 −1 1 1 −1 −1 −1 1 −1 −1 −1 −1 −1 −1 1 −1 1 −1 −1 1 |
| | −1 1 −1 1 1 1 −1 −1 1 1 1 1 −1 −1 −1 −1 1 −1 −1 −1 1 −1 1 −1 −1 −1 1 −1 1 1 1 1 |
| | −1 −1 1 1 1 1 −1 −1 1 1 1 1 1 1 1 −1 −1 −1 1 1 −1 −1 1 1 −1 1 −1 −1 −1 1 −1 1 1 |
| | −1 1 1 1 1 1 −1 1 1 1 −1 1 1 −1 1 1 −1 1 −1 −1 −1 −1 1 1 −1 −1 −1 1 −1 −1 −1 −1 |
| | 1 −1 1 1 1 1 1 −1 −1 1 1 1 −1 −1 1 1 1 1 1 1 1 1 −1 −1 −1 1 1 1 −1 1 −1 −1 −1 1 1 |
| | −1 1 1 1 −1 1 −1 −1 1 1 1 −1 −1 −1 1 −1 −1 −1 1 −1 −1 1 −1 −1 −1 1 −1 1 1 −1 −1 |
| | 1 −1 −1 1 −1 −1 1 −1 1 −1 1 −1 −1 1 −1 −1 1 −1 −1 1 −1 −1 1 1 1 1 −1 −1 −1 −1 |
| | −1 1 −1 1 −1 1 1 −1 1 −1 −1 1 −1 1 1 1 1 −1 1 1 −1 1 1 −1 −1 1 1 1 1 1 1 1 −1 1 |
| | −1 1 −1 −1 1 −1 −1 −1 1 1 −1 1 −1 1 −1 1 −1 1 1 −1 −1 1 −1 −1 −1 −1 1 −1 −1 1 1 |
| | 1 1 1 −1 −1 −1 −1 −1 −1 −1 1 −1 1 −1 −1 −1 1 1 1 −1 −1 1 −1 1 1 −1 −1 −1 −1 −1 |
| | −1 1 1 −1 −1 1 1 1 1 1 −1 −1 1 −1 1 1 −1 1 1 1 1 1 1 1 1 −1 −1 −1 −1 1 1 1 1 1 1 1 |
| | 1 1 1 1 −1 −1 1 −1 −1 −1 1 1 −1 1 −1 −1 −1 1 1 1 −1 1 1 1 −1 1 −1 1 −1 1 1 1 1 1 |
| | 1 −1 1 −1 −1 1 1 1 1 −1 1 −1 −1 −1 1 1 1 1 −1 −1 −1 1 1 −1 −1 −1 −1 −1 −1 1 1 |
| | −1 1 1 1 −1 1 −1 1 1 1 −1 −1 1 1 −1 −1 −1 1 1 1 1 −1 1 −1 −1 1 −1 −1 −1 −1 −1 |
| | −1 1 1 −1 1 1 −1 −1 1 1 1 −1 −1 1 −1 1 −1 −1 1 1 −1 −1 1 1 −1 1 1 1 1 −1 1 1 1 1 |
| | 1 −1 −1 −1 1 −1 −1 −1 1 1 1 1 1 1 1 1 −1 −1 1 1 1 −1 −1 −1 1 1 −1 1 −1 −1 −1 −1 |
| | −1 1 1 −1 −1 1 −1 −1 −1 −1 1 −1 1 1 1 −1 1 −1 1 1 −1 −1 1 −1 1 −1 1 −1 −1 −1 −1 |
| | 1 −1 −1 −1 −1 −1 1 −1 −1 1 1 1 −1 −1 1 1 1 −1 −1 1 −1 −1 1 −1 −1 −1 1 −1 1 −1 |
| | −1 −1 −1 −1 1 −1 1 −1 1 1 1 1 −1 1 1 1 −1 −1 1 1 1 1 −1 1 −1 −1 −1 −1 1 1 −1 −1 |
| | 1 1 −1 1 −1 1 −1 1 1 1 −1 1 −1 1 1 −1 1 1 −1 −1 −1 −1 1 1 −1 −1 −1 −1 1 1 1 1 1 |
| | −1 −1 1 −1 −1 −1 −1 −1 −1 −1 1 1 −1 1 −1 1 1 −1 −1 1 −1 1 1 1 −1 1 −1 1 −1 1 −1 |
| | −1 1 −1 −1 1 1 −1 1 1 −1 −1 −1 −1 1 −1 1 −1 1 1 −1 1 1 −1 1 1 1 −1 −1 −1 −1 1 |
| | −1 −1 −1 −1 1 1 1 1 1 1 −1 −1 1 −1 −1 1 −1 1 1 −1 1 −1 −1 −1 1 −1 1 −1 1 1 −1 |
| | −1 −1 1 −1 −1 1 −1 1 −1 1 −1 1 −1 −1 1 −1 1 −1 1 1 −1 −1 −1 −1 1 −1 −1 1 −1 −1 |
| | 1 1 1 1 1 −1 −1 1 −1 −1 1 −1 −1 1 −1 −1 −1 1 1 −1 −1 1 1 1 −1 1 1 1 1 −1 −1 1 1 |
| | −1 −1 1 1 −1 1 1 −1 1 −1 −1 1 −1 −1 −1 −1 −1 1 1 1 1 1 −1 1 1 1 1 −1 −1 1 −1 1 |
| | −1 −1 −1 1 1 1 1 1 1 1 −1 −1 −1 −1 1 −1 1 1 −1 1 −1 −1 −1 1 1 1 −1 −1 1 1 1 1 1 |
| | −1 1 1 1 −1 1 −1 −1 1 −1 −1 −1 1 1 −1 −1 −1 1 1 1 1 −1 −1 −1 −1 −1 −1 1 1 1 −1 |
| | −1 −1 1 1 −1 −1 1 −1 1 1 1 1 1 1 −1 −1 1 1 −1 −1 1 1 1 1 1 1 1 1 1 −1 −1 −1 1 −1 |
| | 1 −1 −1 −1 1 1 −1 1 −1 −1 1 −1 1 −1 1 −1 1 1 1 1 1 −1 1 1 1 1 −1 1 1 −1 −1 −1 1 1 |
| | −1 1 1 −1 1 −1 −1 1 1 −1 −1 1 −1 −1 −1 −1 1 1 1 1 −1 −1 −1 1 −1 1 −1 1 1 1 −1 1 |
| | −1 −1 −1 −1 −1 −1 1 −1 −1 1 1 −1 1 1 −1 −1 1 −1 1 1 1 1 −1 −1 −1 1 −1 −1 −1 −1 |
| | −1 1 −1 −1 −1 1 1 1 −1 −1 −1 −1 −1 −1 −1 −1 1 −1 1 1 −1 1 −1 1 1 1 −1 −1 1 −1 1 |
| | −1 1 −1 −1 1 1 1 1 1 1 −1 −1 −1 −1 1 −1 −1 1 −1 −1 −1 1 1 −1 1 1 1 −1 −1 −1 −1 |
| | −1 1 −1 1 1 −1 1 1 −1 1 −1 1 1 1 −1 −1 −1 −1 1 1 1 1 1 −1 1 1 −1 1 −1 1 1 1 −1 1 |
| | −1 −1 −1 1 −1 −1 −1 −1 1 −1 −1 −1 1 −1 −1 1 −1 1 −1 1 1 1 −1 1 1 1 −1 1 1 1 1 |
| | −1 1 1 −1 1 −1 1 −1 −1 −1 −1 1 1 −1 1 1 −1 1 1 −1 −1 −1 −1 −1 −1 −1 1 1 1 1 1 |
| | −1 1 −1 1 1 1 −1 −1 1 −1 −1 −1 1 1 −1 −1 −1 −1 1 1 −1 −1 1 1 1 −1 −1 −1 1 −1 1 |
| | 1 1 1 1 −1 −1 −1 1 1 1 −1 −1 −1 −1 1 1 −1 1 −1 1 1 1 1 1 1 −1 −1 1 −1 −1 −1 −1 1 |
| | −1 −1 −1 1 1 −1 1 1 1 1 −1 −1 1 −1 −1 1 −1 1 −1 −1 1 1 −1 1 −1 1 1 −1 −1 1 1 1 1 |
| | −1 −1 −1 1 −1 −1 1 1 −1 −1 1 1 −1 1 −1 1 1 1 1 −1 −1 −1 1 −1 1 −1 −1 1 1 1 1 1 1 |
| | 1 −1 −1 1 1 1 1 −1 −1 −1 1 1 −1 1 −1 −1 1 −1 −1 −1 1 1 1 −1 −1 −1 1 −1 −1 1 −1 |
| | −1 1 −1 1 −1 −1 −1 −1 −1 −1 1 −1 1 −1 1 1 −1 −1 −1 −1 −1 −1 −1 −1 −1 1 −1 −1 |
| | 1 1 −1 −1 1 −1 1 1 1 −1 −1 1 1 1 −1 1 −1 1 1 −1 −1 −1 1 1 1 −1 1 −1 −1 1 1 1 1 1 |
| | −1 −1 1 1 −1 1 1 −1 −1 1 1 −1 1 −1 −1 1 −1 −1 −1 −1 1 1 1 −1 1 −1 1 −1 1 1 −1 |
| | −1 1 −1 1 −1 −1 −1 −1 1 −1 −1 1 1 −1 −1 1 1 1 1 −1 −1 1 −1 −1 1 −1 −1 −1 −1 −1 |
| | 1 1 −1 1 1 1 1 −1 −1 −1 −1 −1 −1 −1 −1 1 1 1 1 1 1 1 −1 −1 1 −1 1 1 1 −1 1 −1 −1 |
| | −1 1 1 −1 −1 1 1 1 1 1 1 −1 1 1 1 −1 1 −1 1 1 −1 1 −1 −1 −1 1 −1 −1 −1 1 −1 −1 1 |
| | 1 −1 −1 −1 −1 −1 −1 1 −1 1 1 −1 −1 1 1 −1 −1 1 −1 1 1 1 1 −1 1 −1 1 1 −1 1 1 1 1 |
| | −1 1 −1 −1 −1 −1 1 −1 −1 −1 −1 1 1 −1 1 1 −1 −1 1 −1 1 −1 1 1 1 −1 1 −1 1 −1 −1 |
| | 1 −1 −1 1 1 1 1 1 1 −1 1 1 −1 −1 1 1 1 −1 1 −1 −1 −1 1 1 1 1 1 −1 −1 −1 1 1 1 1 |
| | −1 −1 1 1 −1 1 −1 −1 1 −1 1 −1 −1 −1 1 −1 1 −1 −1 1 1 1 −1 1 1 −1 −1 1 −1 −1 1 |
| | 1 1 −1 1 −1 −1 1 1 −1 −1 1 1 1 −1 1 −1 −1 1 1 1 −1 1 −1 1 1 −1 1 −1 1 −1 1 1 −1 1 |
| | −1 1 −1 1 −1 −1 1 1 1 1 −1 1 −1 1 −1 1 −1 1 −1 1 1 −1 1 −1 −1 1 1 1 1 −1 1 1 −1 |
| | −1 −1 1 −1 −1 1 −1 −1 −1 1 1 1 1 1 −1 −1 1 1 1 −1 1 1 1 −1 1 −1 −1 −1 1 −1 1 −1 |
| | −1 −1 −1 1 1 −1 −1 −1 −1 −1 −1 1 −1 −1 1 −1 1 1 −1 1 1 1 −1 −1 1 −1 −1 1 −1 −1 |
| | 1 1 −1 −1 −1 1 1 1 −1 1 1 1 1 −1 −1 −1 1 −1 1 1 −1 1 −1 1 −1 −1 −1 1 −1 1 1 −1 |
| | −1 −1 1 −1 −1 1 1 1 −1 −1 −1 −1 1 1 1 −1 −1 −1 −1 −1 1 1 −1 −1 1 −1 1 −1 −1 −1 |
| | −1 −1 −1 −1 −1 1 1 1 −1 1 1 −1 −1 1 −1 1 1 1 −1 −1 −1 1 1 1 1 1 −1 −1 −1 −1 1 1 |
| | −1 −1 1 −1 −1 −1 1 1 −1 −1 1 −1 1 −1 −1 1 −1 −1 1 −1 1 −1 −1 1 −1 −1 1 1 1 −1 1 |
| | 1 1 1 −1 1 1 1 1 −1 −1 −1 1 1 1 1 1 1 1 −1 1 −1 −1 −1 −1 −1 −1 1 1 −1 1 −1 −1 −1 |
| | −1 1 −1 1 1 1 −1 −1 −1 1 −1 −1 1 −1 1 1 −1 −1 −1 1 1 1 −1 −1 −1 −1 −1 1 −1 −1 |
| | −1 −1 −1 −1 1 1 −1 −1 1 −1 1 1 −1 −1 1 −1 1 1 1 1 1 −1 −1 −1 −1 1 1 1 −1 1 1 −1 |
| | 1 −1 −1 −1 −1 −1 −1 −1 1 1 −1 −1 −1 1 −1 −1 1 −1 1 1 1 −1 −1 −1 1 −1 1 1 −1 −1 |
| | 1 1 1 1 1 1 −1 −1 1 1 1 1 1 −1 −1 −1 1 1 −1 1 −1 1 1 −1 1 −1 −1 −1 −1 −1 −1 1 1 1 |
| | 1 −1 1 −1 1 −1 1 1 1 −1 −1 1 1 −1 1 −1 1 −1 1 −1 1 −1 −1 −1 −1 1 1 1 1 −1 1 1 |
| | −1 −1 −1 −1 −1 −1 −1 −1 1 1 −1 1 1 −1 1 1 1 −1 −1 1 −1 1 1 −1 1 1 −1 1 1 −1 1 |
| | −1 1 1 −1 −1 −1 1 −1 −1 −1 −1 1 1 1 1 −1 1 −1 1 1 1 1 −1 −1 1 −1 −1 −1 1 1 1 1 |
| | −1 1 −1 −1 −1 −1 −1 1 −1 1 1 −1 1 −1 −1 1 1 1 −1 −1 1 −1 −1 1 1 −1 −1 −1 −1 −1 |
| | 1 1 −1 −1 1 1 1 −1 1 −1 1 1 1 −1 −1 −1 1 −1 1 −1 −1 −1 −1 1 −1 −1 −1 1 −1 1 1 |
| | −1 −1 −1 −1 −1 −1 −1 1 −1 1 1 −1 −1 −1 1 −1 1 1 1 −1 −1 1 1 1 1 1 −1 −1 1 1 1 1 |
| | 1 1 −1 −1 −1 1 1 −1 1 1 1 1 1 1 1 1 1 −1 −1 1 1 −1 −1 −1 1 1 −1 1 −1 −1 −1 1 −1 1 |
| | −1 −1 1 −1 1 −1 −1 1 1 1 −1 −1 −1 −1 1 −1 1 −1 1 −1 1 1 −1 1 −1 1 1 1 −1 1 1 −1 |
| | −1 −1 −1 1 1 1 1 −1 1 −1 −1 1 1 −1 −1 1 −1 1 −1 −1 −1 1 −1 −1 1 −1 −1 −1 −1 −1 |
| | 1 −1 −1 1 −1 1 −1 1 1 −1 −1 1 −1 1 1 −1 −1 1 1 1 1 −1 1 −1 1 1 −1 −1 −1 1 −1 1 |
| | −1 −1 −1 1 −1 −1 1 1 −1 −1 1 −1 −1 1 1 1 −1 −1 −1 −1 −1 1 1 1 −1 1 1 1 1 1 1 −1 |
| | −1 1 −1 1 −1 −1 −1 −1 1 1 −1 1 −1 −1 1 −1 −1 1 1 1 −1 −1 1 1 −1 −1 −1 −1 −1 1 |
| | −1 1 −1 −1 −1 −1 −1 1 1 1 −1 −1 1 −1 −1 1 1 1 −1 −1 1 −1 −1 −1 1 −1 1 −1 1 1 −1 |
| | 1 −1 1 1 −1 −1 1 −1 −1 1 1 1 1 1 −1 1 1 −1 1 1 1 1 −1 −1 −1 1 1 −1 1 1 −1 1 1 −1 |
| | 1 −1 −1 1 −1 1 −1 −1 1 1 −1 −1 −1 1 −1 −1 1 −1 −1 1 1 1 −1 1 −1 1 1 1 1 −1 −1 |
| | −1 −1 −1 1 1 −1 −1 −1 −1 1 1 −1 1 1 1 −1 −1 1 1 −1 −1 1 −1 1 −1 −1 1 1 −1 1 1 1 |
| | 1 1 −1 −1 −1 −1 1 −1 1 −1 −1 1 1 −1 1 −1 −1 1 −1 1 1 −1 −1 −1 −1 −1 1 1 1 1 −1 |
| | −1 −1 −1 1 1 1 −1 −1 1 −1 −1 −1 1 1 1 −1 −1 1 1 −1 1 1 1 1 −1 −1 1 1 −1 1 1 1 1 1 |
| | −1 1 −1 −1 −1 −1 −1 1 1 1 1 1 1 1 1 −1 1 1 1 −1 −1 1 1 −1 1 −1 −1 −1 1 1 1 1 1 |
| | −1 −1 −1 1 −1 −1 1 −1 1 −1 −1 −1 1 1 −1 −1 1 −1 −1 1 −1 −1 1 1 1 −1 −1 −1 1 −1 |
| | 1 −1 1 1 −1 −1 1 1 −1 1 1 1 −1 1 1 −1 −1 −1 1 −1 1 −1 −1 1 1 −1 1 1 −1 1 1 1 −1 1 |
| | 1 −1 −1 1 1 −1 −1 −1 1 −1 −1 −1 1 −1 −1 −1 −1 −1 1 1 1 −1 −1 −1 −1 −1 −1 1 −1 |
| | 1 1 1 −1 1 −1 −1 1 −1 1 1 1 −1 1 1 −1 1 −1 1 −1 1 1 −1 −1 −1 1 1 1 1 1 −1 1 1 −1 |
| | −1 −1 1 −1 1 1 −1 1 −1 −1 −1 −1 1 1 1 −1 −1 −1 −1 1 1 1 1 −1 −1 1 −1 −1 −1 1 −1 |
| | 1 1 1 1 1 1 1 −1 −1 −1 −1 −1 −1 1 −1 −1 −1 1 1 −1 1 −1 1 1 1 −1 −1 1 1 1 −1 −1 |
| | −1 1 −1 −1 1 1 −1 1 1 1 1 1 1 −1 −1 1 1 1 −1 1 −1 1 −1 −1 −1 1 1 −1 −1 1 1 −1 1 1 |
| | −1 −1 −1 −1 −1 −1 1 1 1 −1 1 −1 1 −1 −1 1 −1 1 1 1 −1 1 −1 −1 1 1 1 1 −1 −1 −1 |
| | −1 1 1 −1 −1 −1 −1 −1 1 1 −1 1 1 1 −1 −1 −1 1 −1 1 1 1 −1 1 −1 1 −1 −1 −1 −1 −1 |
| | −1 1 −1 −1 −1 1 −1 −1 1 1 1 −1 −1 1 −1 1 −1 1 1 1 1 −1 −1 −1 1 1 1 −1 1 1 −1 −1 |
| | −1 1 1 −1 −1 1 −1 −1 −1 1 −1 −1 −1 −1 −1 −1 1 1 1 −1 1 1 1 −1 1 1 1 −1 −1 1 −1 |
| | −1 −1 1 −1 −1 −1 1 −1 −1 −1 1 −1 1 −1 1 1 1 1 −1 −1 1 1 1 −1 −1 −1 −1 1 −1 −1 |
| | −1 1 1 1 −1 1 −1 −1 1 −1 1 1 −1 −1 1 −1 −1 −1 1 −1 −1 1 −1 −1 1 1 −1 −1 1 1 1 |
| | −1 −1 −1 −1 −1 1 −1 1 −1 −1 1 −1 −1 −1 1 −1 1 1 1 −1 1 1 −1 −1 1 1 1 −1 −1 −1 |
| | −1 1 1 −1 −1 −1 1 −1 1 −1 −1 −1 −1 −1 −1 −1 1 1 1 −1 −1 −1 −1 1 −1 1 1 1 −1 −1 |
| | 1 1 −1 1 1 1 −1 −1 −1 −1 1 1 −1 −1 1 1 −1 −1 −1 1 1 1 −1 −1 1 1 −1 −1 1 1 −1 −1 |
| | 1 −1 −1 −1 1 −1 1 −1 −1 1 −1 −1 −1 −1 −1 1 −1 1 1 −1 −1 −1 −1 −1 1 −1 1 1 1 −1 |
| | 1 1 −1 1 1 1 −1 −1 1 1 1 1 1 1 −1 1 −1 1 −1 −1 −1 −1 −1 1 1 −1 1 −1 −1 1 1 1 1 −1 |
| | −1 1 −1 1 −1 −1 1 1 1 −1 1 −1 −1 −1 −1 −1 1 −1 −1 1 −1 −1 −1 1 −1 −1 1 −1 1 1 1 |
| | 1 −1 −1 −1 −1 −1 −1 1 −1 1 −1 1 −1 −1 −1 1 −1 1 1 1 −1 −1 −1 −1 1 −1 −1 1 −1 1 |
| | −1 1 −1 −1 −1 −1 −1 −1 −1 1 −1 1 −1 1 −1 1 −1 1 1 1 −1 −1 1 −1 −1 1 1 1 1 −1 1 |
| | 1 −1 1 −1 1 1 −1 −1 1 1 −1 1 −1 1 −1 −1 1 1 1 1 1 −1 −1 −1 1 −1 −1 1 1 1 −1 1 −1 |
| | −1 −1 1 −1 1 1 −1 −1 1 1 −1 1 1 −1 −1 1 −1 −1 1 1 −1 −1 1 1 −1 −1 −1 1 −1 1 −1 |
| | 1 1 −1 1 1 1 1 1 −1 −1 1 1 1 1 −1 1 −1 1 −1 −1 −1 1 1 1 −1 1 −1 −1 −1 −1 1 −1 −1 |
| | 1 −1 1 −1 −1 −1 −1 1 −1 1 1 1 1 −1 −1 −1 −1 1 −1 1 1 1 1 −1 1 −1 −1 −1 −1 −1 −1 |
| | −1 1 −1 −1 −1 1 1 1 1 −1 −1 1 −1 1 1 1 1 −1 −1 1 1 −1 1 −1 1 1 −1 −1 −1 1 1 −1 |
| | −1 1 1 −1 −1 −1 −1 1 1 1 −1 −1 −1 1 −1 1 −1 −1 1 −1 1 1 −1 1 −1 1 1 1 1 −1 1 1 1 |
| | 1 −1 1 −1 1 −1 1 −1 −1 −1 1 −1 −1 −1 1 1 1 1 −1 1 1 −1 −1 1 −1 −1 1 −1 1 −1 −1 |
| | −1 1 −1 −1 −1 −1 −1 1 −1 1 −1 1 −1 1 1 1 1 −1 −1 1 −1 1 −1 1 −1 1 −1 1 −1 −1 −1 |
| | 1 −1 1 −1 1 −1 1 −1 1 −1 1 −1 1 1 1 1 −1 1 1 −1 −1 −1 −1 1 −1 −1 1 1 −1 1 −1 1 |
| | −1 −1 1 −1 1 1 −1 −1 1 1 −1 −1 −1 −1 1 −1 1 −1 1 −1 −1 1 −1 −1 −1 −1 −1 −1 −1 |
| | 1 −1 −1 1 1 1 −1 1 1 1 −1 −1 1 −1 1 −1 1 1 −1 1 −1 1 −1 −1 −1 −1 −1 1 −1 −1 1 1 |
| | −1 −1 −1 −1 1 −1 1 1 1 −1 1 1 1 1 1 −1 −1 1 −1 −1 1 1 −1 1 1 −1 1 −1 −1 −1 −1 |
| | −1 1 −1 1 −1 −1 1 1 −1 −1 −1 −1 −1 −1 −1 −1 1 −1 −1 1 −1 −1 −1 −1 −1 −1 −1 −1 |
| | −1 −1 −1 1 −1 1 −1 1 1 1 −1 −1 1 −1 1 1 1 −1 1 1 −1 −1 −1 1 1 1 −1 1 1 −1 1 −1 1 |
| | −1 −1 1 −1 1 −1 −1 −1 −1 1 1 1 1 −1 1 1 1 1 −1 1 1 1 −1 −1 −1 1 1 −1 −1 −1 1 1 |
| | −1 −1 −1 1 1 1 −1 −1 −1 1 −1 1 1 −1 1 1 1 −1 1 −1 −1 1 −1 1 −1 1 −1 −1 1 1 −1 1 |
| | 1 −1 −1 1 1 1 1 −1 1 1 1 1 1 −1 1 −1 1 1 −1 1 −1 −1 1 1 −1 1 −1 −1 1 1 1 1 1 −1 1 |
| | 1 1 1 1 −1 1 1 1 1 1 1 1 1 −1 1 −1 −1 −1 1 −1 −1 −1 1 1 −1 1 −1 −1 1 1 1 −1 −1 −1 |
| | −1 −1 −1 1 1 1 1 −1 −1 −1 1 1 1 −1 −1 1 −1 1 −1 −1 −1 1 −1 1 1 −1 1 −1 1 1 −1 |
| | −1 −1 −1 −1 −1 1 −1 −1 −1 −1 1 −1 −1 −1 −1 −1 −1 −1 −1 −1 1 −1 1 1 1 1 −1 −1 |
| | 1 −1 1 1 1 −1 −1 −1 −1 1 1 −1 1 1 1 1 −1 1 −1 −1 1 −1 1 1 −1 1 1 −1 1 −1 −1 1 1 1 |
| | −1 1 1 −1 1 1 −1 1 1 −1 −1 1 1 −1 1 1 −1 1 1 −1 1 1 −1 1 1 1 1 1 −1 1 −1 1 −1 −1 |
| | 1 1 −1 −1 −1 1 1 −1 1 1 −1 −1 −1 −1 −1 1 1 1 −1 −1 −1 1 −1 −1 −1 −1 −1 −1 −1 |
| | −1 1 1 −1 −1 1 −1 −1 1 −1 1 1 1 −1 −1 1 1 −1 −1 1 1 1 −1 1 1 −1 1 −1 1 1 −1 1 1 1 |
| | 1 1 1 −1 1 −1 1 −1 1 −1 −1 1 1 −1 1 −1 −1 −1 −1 1 −1 −1 1 1 1 −1 1 −1 1 −1 1 1 1 |
| | −1 1 1 1 1 1 1 −1 1 1 −1 −1 −1 1 1 1 1 1 1 1 1 1 −1 1 −1 1 1 1 1 1 1 1 1 1 1 1 1 −1 |
| | 1 1 −1 1 −1 −1 −1 1 1 −1 1 −1 −1 −1 −1 1 1 1 1 −1 −1 1 1 −1 −1 −1 −1 −1 −1 −1 1 |
| | 1 −1 1 1 1 1 1 −1 −1 1 −1 1 1 1 1 1 −1 1 −1 −1 −1 1 −1 1 −1 1 −1 −1 −1 1 1 1 1 −1 |
| | −1 1 1 1 1 −1 1 1 1 −1 1 −1 −1 −1 −1 −1 1 1 −1 1 1 −1 1 −1 1 −1 1 1 1 −1 −1 −1 1 |
| | −1 −1 −1 −1 1 −1 −1 1 1 −1 1 1 1 −1 1 1 1 −1 −1 −1 −1 −1 1 1 1 1 1 1 1 −1 1 −1 −1 |
| | 1 −1 1 1 1 1 1 1 1 1 1 −1 1 1 1 1 −1 1 −1 −1 −1 1 1 −1 1 −1 1 −1 −1 −1 1 −1 −1 1 |
| | −1 1 −1 −1 1 1 1 1 −1 −1 1 1 1 −1 1 1 −1 −1 1 1 −1 1 −1 1 1 −1 1 −1 1 −1 −1 1 −1 |
| | −1 −1 −1 1 −1 −1 −1 −1 1 −1 −1 1 −1 −1 1 −1 1 1 −1 −1 1 −1 1 −1 1 1 −1 −1 1 1 1 |
| | 1 1 −1 −1 −1 −1 1 −1 −1 −1 −1 −1 1 1 −1 1 −1 1 1 1 −1 1 1 1 −1 −1 1 1 −1 −1 −1 |
| | −1 1 1 −1 −1 −1 1 1 1 −1 −1 1 1 1 −1 1 −1 1 1 1 1 1 1 −1 1 1 −1 1 −1 1 −1 1 −1 |
| | −1 −1 1 1 −1 −1 −1 1 −1 −1 1 1 1 1 −1 −1 1 1 −1 −1 1 −1 −1 1 −1 −1 −1 1 1 1 −1 |
| | 1 −1 1 1 −1 −1 1 1 1 −1 −1 −1 1 1 1 1 −1 1 −1 1 1 −1 1 −1 1 1 1 1 1 1 1 −1 1 1 −1 |
| | 1 1 −1 −1 −1 1 1 −1 1 −1 −1 1 1 −1 −1 −1 1 −1 1 1 −1 1 1 −1 −1 1 1 −1 −1 1 −1 |
| | −1 1 1 −1 −1 −1 1 −1 1 −1 −1 1 −1 −1 1 −1 −1 −1 −1 −1 −1 1 −1 −1 1 −1 −1 1 −1 |
| | −1 1 −1 1 1 1 −1 1 1 1 1 −1 −1 −1 −1 −1 1 −1 −1 −1 1 −1 −1 −1 1 1 1 −1 −1 1 −1 |
| | −1 1 −1 1 −1 1 1 1 1 1 1 −1 −1 −1 −1 −1 1 −1 −1 1 1 −1 1 −1 −1 −1 −1 −1 −1 −1 |
| | −1 1 −1 1 −1 −1 1 1 1 −1 −1 1 −1 1 1 1 1 −1 1 1 1 1 1 1 −1 −1 −1 −1 1 1 −1 1 1 −1 |
| | 1 −1 −1 −1 1 −1 1 1 1 1 1 −1 1 −1 1 −1 1 1 1 1 −1 1 −1 −1 −1 1 −1 −1 1 1 1 1 1 1 |
| | 1 −1 1 1 1 −1 1 1 1 1 1 1 1 1 1 1 −1 1 −1 −1 1 1 −1 1 −1 −1 −1 1 1 −1 1 1 −1 −1 1 |
| | 1 −1 −1 −1 −1 −1 −1 1 1 1 1 1 −1 −1 −1 1 −1 1 1 1 −1 −1 −1 1 1 −1 1 1 1 −1 1 1 |
| | −1 1 −1 1 1 1 1 1 −1 1 −1 −1 1 1 −1 −1 −1 −1 1 1 −1 1 −1 1 −1 1 1 −1 1 1 1 −1 −1 |
| | −1 1 −1 −1 1 1 1 1 1 −1 1 −1 −1 1 −1 1 −1 1 1 −1 1 −1 −1 −1 −1 1 −1 1 −1 1 −1 1 |
| | −1 −1 1 1 1 −1 −1 1 1 1 1 −1 1 1 −1 −1 1 1 −1 1 1 1 1 1 1 1 −1 1 −1 1 1 −1 1 1 −1 |
| | 1 −1 −1 −1 1 1 1 1 −1 1 −1 1 −1 −1 1 1 1 −1 −1 −1 1 1 −1 −1 −1 −1 1 −1 1 −1 −1 |
| | −1 −1 −1 −1 1 1 1 −1 −1 1 1 1 1 −1 −1 1 −1 1 1 −1 1 −1 1 1 −1 1 −1 −1 1 −1 −1 1 |
| | 1 −1 −1 −1 −1 1 1 1 1 −1 −1 −1 −1 −1 1 1 1 −1 −1 1 1 −1 1 −1 1 1 1 −1 −1 −1 1 1 |
| | 1 −1 1 −1 1 −1 1 −1 −1 −1 −1 −1 −1 1 1 −1 −1 −1 −1 1 −1 −1 1 −1 1 1 1 −1 1 −1 1 |
| | 1 1 −1 1 1 1 1 −1 1 −1 −1 1 1 1 1 1 1 −1 1 −1 −1 −1 −1 1 −1 1 −1 −1 −1 1 1 −1 −1 |
| | −1 −1 −1 −1 −1 1 −1 −1 1 −1 1 −1 −1 1 −1 1 1 1 −1 −1 −1 −1 −1 1 −1 −1 1 −1 −1 |
| | 1 1 −1 1 1 1 −1 −1 1 1 1 −1 1 1 1 1 1 −1 1 −1 −1 1 −1 −1 −1 1 −1 −1 −1 1 1 −1 −1 |
| | −1 −1 −1 1 −1 1 1 −1 −1 1 −1 −1 −1 −1 −1 −1 −1 −1 1 −1 −1 −1 −1 −1 1 −1 1 1 1 |
| | −1 −1 1 −1 −1 1 −1 1 1 1 1 −1 1 −1 −1 1 −1 −1 1 −1 −1 1 1 −1 1 −1 1 −1 1 1 −1 |
| | −1 1 1 1 −1 1 −1 1 −1 1 −1 1 −1 −1 1 −1 −1 −1 1 −1 −1 1 1 1 1 −1 1 1 1 1 −1 −1 1 |
| | 1 1 −1 1 −1 −1 −1 −1 1 1 −1 1 1 1 1 1 1 −1 1 1 1 −1 −1 −1 1 −1 −1 −1 1 1 −1 1 1 |
| | −1 1 −1 1 1 1 1 −1 −1 1 1 −1 −1 −1 1 −1 −1 1 1 −1 1 −1 1 1 −1 1 1 1 −1 1 1 1 1 1 |
| | −1 1 1 −1 1 1 −1 1 −1 1 −1 −1 −1 1 1 1 1 1 −1 1 −1 1 −1 1 −1 1 1 1 1 1 1 1 1 −1 1 |
| | 1 −1 −1 −1 −1 1 1 −1 1 −1 −1 −1 1 −1 −1 −1 −1 −1 −1 −1 1 1 1 1 −1 −1 1 1 1 −1 |
| | −1 1 −1 1 1 −1 1 −1 −1 1 −1 −1 −1 1 −1 1 −1 1 −1 −1 1 1 1 −1 1 1 1 −1 1 1 −1 −1 |
| | −1 −1 −1 1 1 −1 −1 −1 1 1 1 1 1 −1 −1 1 −1 1 −1 −1 1 −1 1 −1 −1 −1 1 1 1 −1 1 1 |
| | −1 −1 1 1 1 1 −1 −1 1 1 −1 1 1 −1 1 1 1 1 1 1 1 −1 −1 −1 1 −1 −1 −1 −1 1 1 −1 1 |
| | −1 −1 −1 −1 −1 −1 1 −1 1 1 1 1 1 −1 1 1 1 −1 −1 1 −1 −1 1 1 −1 1 −1 −1 1 1 −1 1 |
| | 1 1 1 −1 −1 −1 1 −1 −1 1 −1 −1 −1 −1 1 1 −1 1 1 1 −1 1 1 1 1 −1 −1 1 −1 −1 −1 |
| | −1 1 1 −1 −1 −1 1 1 −1 −1 1 1 1 −1 −1 1 1 −1 −1 1 −1 −1 −1 −1 −1 1 1 −1 −1 1 1 |
| | −1 −1 1 1 1 −1 −1 1 −1 −1 −1 −1 −1 1 1 1 −1 1 −1 −1 1 −1 −1 1 −1 1 1 1 1 1 1 −1 |
| | 1 1 1 1 −1 −1 −1 −1 1 1 −1 1 −1 −1 1 1 −1 1 −1 1 1 1 −1 1 −1 1 −1 1 1 −1 1 1 −1 |
| | −1 −1 1 1 1 1 −1 1 1 −1 1 1 −1 1 1 1 −1 1 −1 −1 −1 −1 1 1 1 1 1 −1 1 −1 −1 1 1 1 |
| | −1 −1 1 1 −1 1 −1 −1 1 1 1 −1 1 −1 −1 1 −1 −1 −1 −1 1 −1 1 −1 −1 −1 −1 1 −1 1 |
| | −1 1 1 1 −1 1 1 −1 −1 1 −1 1 −1 1 −1 1 −1 −1 −1 −1 1 1 1 −1 1 1 −1 −1 −1 −1 1 |
| | −1 1 1 1 1 1 1 −1 1 −1 1 1 1 −1 1 1 −1 1 −1 −1 −1 1 −1 −1 1 1 −1 1 1 −1 1 1 −1 −1 |
| | 1 −1 −1 1 −1 −1 −1 −1 1 1 1 1 1 −1 −1 −1 −1 −1 1 −1 1 1 1 1 1 1 1 1 −1 −1 1 −1 1 |
| | −1 1 −1 −1 −1 1 1 −1 1 −1 1 1 −1 −1 −1 −1 1 −1 1 1 −1 1 1 −1 −1 −1 1 −1 1 1 1 1 |
| | −1 1 −1 1 −1 −1 1 −1 1 −1 1 −1 −1 −1 1 −1 −1 1 1 1 −1 1 1 −1 −1 −1 −1 −1 −1 1 |
| | −1 1 −1 −1 −1 −1 1 1 1 −1 −1 1 −1 1 −1 1 −1 1 1 1 −1 1 −1 −1 1 −1 −1 1 1 1 1 −1 |
| | 1 −1 −1 1 1 1 −1 1 1 1 1 1 1 1 −1 1 1 1 1 1 1 −1 1 −1 −1 −1 1 1 −1 −1 −1 1 1 −1 1 |
| | −1 1 −1 1 1 1 1 1 −1 −1 1 1 −1 −1 −1 −1 1 −1 −1 −1 1 1 −1 −1 1 1 −1 −1 1 −1 1 |
| | −1 1 1 1 1 1 −1 −1 −1 1 −1 1 −1 1 −1 1 −1 −1 −1 1 1 1 −1 −1 −1 −1 1 −1 −1 1 1 1 |
| | −1 −1 −1 1 1 1 −1 −1 1 1 1 −1 1 −1 −1 1 −1 1 −1 −1 −1 −1 −1 1 1 −1 −1 −1 −1 −1 |
| | 1 −1 −1 1 −1 1 1 1 1 1 −1 −1 1 −1 1 −1 1 1 −1 −1 −1 1 1 −1 1 1 1 1 −1 1 1 −1 1 1 |
| | 1 −1 1 −1 1 −1 −1 −1 1 −1 −1 −1 −1 1 1 −1 −1 −1 −1 1 −1 1 1 −1 −1 1 −1 1 −1 −1 |
| | 1 −1 1 1 −1 −1 −1 1 −1 1 −1 1 −1 1 1 −1 −1 −1 1 −1 1 1 −1 −1 −1 −1 1 −1 −1 −1 |
| | −1 −1 −1 1 −1 −1 −1 −1 −1 −1 −1 1 −1 1 1 1 −1 −1 −1 −1 −1 −1 −1 −1 −1 −1 1 −1 |
| | −1 −1 1 −1 1 1 1 −1 −1 1 −1 1 1 −1 −1 1 −1 −1 1 1 −1 1 1 1 1 −1 1 −1 1 1 −1 −1 1 |
| | 1 −1 −1 −1 1 1 −1 −1 −1 −1 1 1 1 −1 1 −1 1 1 1 1 1 −1 −1 1 −1 −1 −1 1 −1 −1 1 1 |
| | −1 1 −1 −1 1 −1 −1 1 −1 1 −1 1 1 −1 1 1 −1 −1 1 1 1 −1 1 1 −1 −1 −1 1 −1 −1 −1 |
| | −1 −1 1 1 −1 −1 −1 1 −1 1 1 −1 −1 1 −1 1 1 −1 1 1 1 −1 1 1 −1 1 1 1 1 −1 1 −1 1 |
| | −1 −1 −1 −1 1 1 1 1 1 1 1 −1 1 1 −1 −1 1 −1 1 −1 −1 −1 1 1 −1 1 1 −1 1 1 1 1 −1 1 |
| | 1 1 −1 1 −1 1 −1 −1 1 1 −1 1 −1 1 −1 −1 −1 −1 1 −1 −1 1 −1 −1 −1 −1 1 −1 −1 1 |
| | −1 1 1 −1 −1 1 1 1 −1 −1 1 1 1 −1 1 1 −1 1 1 1 1 1 1 −1 −1 −1 1 1 1 1 1 −1 1 −1 |
| | −1 −1 1 1 1 −1 −1 −1 1 1 −1 1 1 −1 −1 1 −1 −1 −1 1 −1 1 1 −1 1 1 −1 1 1 1 1 −1 |
| | −1 1 1 1 1 1 −1 1 −1 1 −1 −1 −1 1 −1 1 −1 −1 −1 1 1 1 1 −1 1 1 1 −1 1 1 −1 −1 1 |
| | −1 −1 −1 1 1 1 1 1 1 −1 1 −1 1 1 −1 −1 1 −1 −1 −1 1 1 −1 1 1 −1 −1 −1 1 −1 1 −1 |
| | 1 1 1 1 1 −1 1 −1 1 1 1 1 −1 1 1 −1 1 −1 −1 −1 −1 1 −1 −1 −1 1 1 1 1 1 −1 1 1 1 |
| | −1 −1 −1 −1 −1 −1 1 1 −1 1 −1 1 −1 −1 −1 −1 −1 −1 −1 −1 −1 1 1 1 1 −1 1 1 1 −1 |
| | −1 1 −1 1 1 1 1 1 1 1 −1 1 −1 −1 1 −1 −1 1 1 −1 1 −1 −1 −1 1 −1 −1 1 −1 −1 1 −1 |
| | −1 −1 −1 1 −1 1 1 −1 1 1 1 −1 1 1 1 −1 −1 −1 −1 1 1 1 −1 1 −1 −1 1 1 −1 1 1 1 |
| | −1 −1 −1 1 1 1 1 −1 −1 −1 1 −1 −1 −1 1 −1 1 1 −1 1 −1 −1 1 −1 1 −1 1 1 1 1 −1 1 |
| | −1 1 −1 1 1 −1 −1 −1 −1 1 1 −1 1 1 −1 −1 −1 −1 1 1 1 −1 −1 1 1 −1 −1 −1 1 −1 1 |
| | 1 1 1 1 1 −1 −1 −1 1 −1 1 1 −1 −1 −1 1 1 −1 1 −1 1 1 1 1 −1 1 −1 1 1 1 1 1 −1 1 1 |
| | −1 1 −1 −1 1 1 1 1 1 1 1 1 −1 1 −1 1 −1 1 1 −1 1 −1 −1 −1 1 1 −1 −1 −1 −1 1 −1 |
| | −1 −1 −1 1 −1 1 1 −1 1 1 1 −1 −1 −1 −1 −1 −1 −1 1 −1 −1 −1 −1 1 1 −1 −1 1 −1 1 |
| | 1 1 −1 1 1 1 −1 −1 −1 1 −1 1 −1 1 −1 −1 −1 −1 1 1 −1 −1 1 −1 −1 1 1 1 1 −1 −1 1 |
| | −1 −1 −1 −1 −1 1 −1 1 −1 −1 −1 1 −1 1 −1 1 1 1 −1 −1 −1 −1 1 −1 1 1 −1 −1 −1 |
| | −1 1 1 −1 −1 1 −1 1 −1 1 −1 −1 1 −1 1 1 −1 1 1 1 1 −1 1 1 −1 −1 1 1 1 1 1 −1 1 −1 |
| | −1 −1 −1 1 1 1 −1 1 −1 −1 −1 1 −1 −1 1 −1 1 1 −1 1 −1 1 −1 1 1 1 1 −1 −1 −1 −1 |
| | 1 1 1 1 −1 1 1 −1 1 −1 −1 1 −1 1 1 −1 1 −1 −1 1 1 −1 −1 −1 −1 −1 1 −1 −1 −1 −1 |
| | 1 −1 1 −1 −1 1 −1 1 1 1 1 −1 −1 1 −1 −1 1 1 1 −1 1 1 −1 1 −1 −1 1 −1 −1 1 −1 −1 |
| | −1 1 −1 −1 −1 −1 1 −1 1 −1 1 1 −1 −1 1 −1 −1 1 −1 1 1 −1 −1 −1 −1 1 1 1 −1 1 1 |
| | 1 1 −1 1 −1 1 1 1 −1 1 −1 −1 1 1 −1 1 −1 1 −1 1 −1 −1 −1 −1 1 −1 1 −1 −1 1 1 1 1 |
| | −1 1 1 1 −1 −1 −1 −1 1 −1 1 −1 −1 −1 1 −1 −1 −1 1 −1 1 1 1 1 −1 1 1 1 −1 1 1 1 |
| | −1 1 1 −1 1 −1 −1 1 1 −1 1 1 −1 1 −1 1 −1 −1 1 1 1 −1 1 −1 1 −1 −1 1 1 1 1 −1 −1 |
| | −1 1 1 1 1 −1 1 1 1 1 1 1 1 −1 −1 1 1 −1 1 −1 1 −1 −1 −1 1 1 −1 1 1 1 1 1 −1 1 1 |
| | −1 −1 1 −1 −1 −1 −1 1 1 −1 1 −1 1 −1 −1 1 −1 −1 1 −1 1 1 −1 1 1 −1 −1 −1 −1 −1 |
| | 1 −1 1 −1 1 −1 −1 1 1 −1 −1 1 −1 1 1 −1 −1 −1 −1 1 −1 1 −1 −1 1 −1 −1 1 1 −1 −1 |
| | 1 −1 1 −1 1 −1 1 1 −1 −1 1 1 −1 −1 1 1 1 1 −1 1 1 −1 1 1 1 1 1 −1 −1 −1 1 1 −1 −1 |
| | −1 1 −1 −1 −1 1 1 −1 −1 1 −1 −1 −1 −1 −1 −1 1 −1 1 1 −1 1 1 1 1 −1 −1 1 −1 1 1 |
| | −1 −1 −1 1 −1 −1 −1 1 1 1 −1 1 1 −1 1 1 1 −1 1 1 1 −1 1 −1 −1 1 1 −1 −1 −1 1 1 1 |
| | 1 1 1 −1 1 1 1 1 1 −1 −1 1 1 −1 1 −1 −1 −1 −1 1 1 −1 1 −1 1 1 −1 1 1 −1 −1 1 −1 1 |
| | −1 −1 1 1 1 1 1 −1 1 −1 1 1 −1 −1 −1 −1 −1 1 1 −1 1 −1 1 −1 1 −1 −1 1 −1 1 1 1 1 |
| | 1 −1 1 1 −1 −1 −1 −1 −1 1 −1 −1 −1 1 1 −1 −1 −1 1 −1 1 1 1 −1 1 1 1 −1 1 −1 1 1 |
| | 1 1 −1 1 −1 −1 1 1 −1 1 1 −1 −1 −1 1 1 −1 −1 −1 −1 −1 1 1 1 1 1 −1 −1 1 1 −1 −1 |
| | 1 −1 1 1 −1 1 −1 −1 −1 −1 −1 1 1 1 −1 1 1 −1 1 1 −1 −1 1 −1 1 1 −1 1 −1 1 −1 −1 |
| | 1 1 −1 −1 1 1 1 1 1 −1 1 1 −1 −1 1 1 −1 −1 1 1 −1 1 −1 −1 1 1 −1 −1 1 1 −1 −1 1 1 |
| | −1 −1 −1 −1 −1 1 1 1 −1 1 −1 1 1 −1 1 1 1 −1 −1 1 1 −1 1 1 −1 −1 −1 1 −1 −1 −1 |
| | 1 −1 1 −1 −1 1 1 −1 −1 1 −1 −1 1 −1 1 −1 1 −1 1 1 −1 1 1 1 1 −1 −1 −1 −1 1 −1 |
| | −1 1 1 −1 −1 −1 1 1 −1 −1 1 −1 1 −1 1 1 −1 1 1 1 −1 1 −1 1 1 −1 −1 −1 −1 1 1 1 1 |
| | 1 1 −1 1 1 −1 1 1 1 −1 −1 −1 1 1 −1 1 −1 1 −1 −1 1 1 −1 1 1 1 −1 1 −1 1 −1 1 −1 1 |
| | 1 −1 1 1 −1 1 −1 1 −1 1 −1 1 −1 1 −1 −1 1 1 −1 −1 −1 −1 1 −1 −1 1 1 1 1 −1 −1 |
| | −1 1 −1 1 1 1 1 −1 −1 −1 1 1 −1 −1 1 −1 −1 1 1 −1 1 −1 1 1 1 1 1 −1 −1 −1 −1 −1 |
| | 1 1 1 1 −1 1 −1 −1 −1 1 −1 1 1 1 −1 1 −1 −1 −1 −1 1 −1 1 1 −1 −1 −1 1 1 1 1 −1 |
| | −1 1 −1 −1 1 1 −1 −1 1 −1 −1 −1 1 1 1 −1 1 1 1 1 1 −1 −1 −1 −1 −1 −1 1 1 −1 −1 |
| | −1 1 1 −1 1 1 1 −1 −1 1 −1 −1 −1 −1 −1 −1 1 1 1 1 1 1 −1 −1 −1 −1 −1 −1 −1 −1 |
| | −1 1 1 −1 1 −1 −1 1 −1 1 1 1 −1 −1 1 −1 −1 −1 −1 1 −1 1 −1 1 −1 −1 −1 −1 −1 1 |
| | −1 1 1 1 1 −1 1 1 −1 −1 1 −1 1 1 −1 −1 −1 1 1 −1 −1 −1 1 −1 1 −1 1 −1 −1 1 −1 1 |
| | −1 −1 1 −1 1 −1 1 −1 1 −1 1 1 −1 −1 −1 −1 −1 1 −1 −1 1 1 1 1 −1 1 −1 1 1 1 −1 |
| | −1 −1 −1 −1 1 1 −1 1 1 −1 −1 −1 1 1 1 −1 −1 1 −1 −1 −1 −1 1 1 1 −1 −1 −1 1 1 1 |
| | −1 1 1 1 −1 −1 −1 1 1 1 −1 −1 −1 1 1 1 1 1 1 −1 −1 1 1 −1 1 1 1 −1 1 −1 −1 −1 1 1 |
| | 1 −1 1 −1 1 −1 −1 −1 −1 1 −1 1 1 −1 1 −1 1 −1 1 −1 1 1 1 −1 1 1 −1 1 1 −1 −1 −1 |
| | −1 1 −1 −1 −1 1 −1 −1 −1 −1 1 1 1 −1 −1 1 1 1 −1 −1 −1 −1 −1 −1 −1 1 1 −1 −1 1 |
| | 1 −1 1 1 1 −1 −1 1 −1 1 −1 −1 1 −1 −1 −1 −1 1 1 −1 −1 1 1 1 1 −1 −1 −1 −1 −1 −1 |
| | −1 1 1 1 −1 1 −1 −1 −1 −1 −1 −1 −1 −1 −1 −1 1 1 |
| 16 | −1 −1 −1 −1 −1 −1 −1 −1 −1 −1 −1 −1 −1 1 1 −1 −1 1 1 −1 −1 −1 1 1 −1 −1 −1 −1 |
| | 1 −1 −1 −1 1 1 1 1 −1 1 −1 1 −1 1 −1 −1 −1 1 −1 1 −1 −1 −1 −1 1 −1 −1 1 1 1 −1 |
| | −1 1 −1 1 1 −1 −1 −1 1 −1 −1 −1 −1 1 −1 1 1 −1 1 −1 −1 1 −1 −1 −1 1 1 −1 −1 −1 |
| | −1 1 −1 1 −1 −1 1 −1 1 1 1 −1 −1 −1 −1 −1 −1 −1 −1 1 1 −1 1 −1 −1 1 1 1 −1 −1 |
| | −1 1 1 1 −1 −1 −1 1 1 −1 1 −1 1 1 −1 −1 −1 1 −1 −1 −1 1 1 1 1 −1 −1 −1 −1 −1 −1 |
| | −1 1 −1 1 1 1 1 −1 −1 −1 −1 1 −1 1 −1 1 −1 −1 −1 1 −1 −1 1 1 1 1 −1 1 1 1 −1 −1 |
| | 1 1 1 −1 −1 1 1 −1 1 −1 −1 −1 1 −1 1 −1 1 1 −1 −1 −1 1 1 −1 −1 1 1 1 1 −1 1 1 −1 |
| | −1 −1 1 1 1 −1 −1 −1 −1 −1 1 −1 1 −1 −1 1 −1 1 −1 1 1 −1 1 −1 1 −1 −1 1 1 −1 −1 |
| | 1 −1 1 −1 1 1 1 −1 −1 1 −1 −1 1 1 1 −1 −1 −1 1 1 −1 −1 1 −1 −1 1 1 1 −1 −1 1 1 |
| | −1 −1 1 1 1 −1 1 −1 1 1 −1 1 1 1 1 1 1 −1 −1 1 −1 −1 −1 1 −1 −1 −1 −1 1 1 1 1 −1 |
| | 1 −1 −1 1 1 1 −1 1 1 1 −1 1 1 −1 1 −1 −1 1 1 1 −1 1 1 −1 −1 −1 1 1 1 1 −1 1 −1 1 |
| | 1 1 1 −1 1 1 1 1 −1 1 −1 1 1 −1 −1 −1 −1 1 −1 1 1 −1 1 −1 1 1 1 −1 1 1 −1 −1 −1 1 |
| | −1 −1 −1 1 −1 1 −1 −1 1 −1 1 −1 −1 1 1 1 1 1 1 −1 1 −1 −1 1 1 −1 1 1 −1 1 1 1 −1 |
| | 1 −1 1 −1 −1 −1 1 1 1 1 1 1 1 −1 1 −1 1 1 −1 1 −1 −1 1 −1 1 1 −1 −1 1 1 1 1 1 1 |
| | −1 1 1 1 −1 −1 1 −1 −1 1 1 −1 −1 1 −1 −1 1 1 −1 1 1 −1 −1 1 1 −1 1 −1 1 −1 1 1 1 |
| | 1 1 −1 1 −1 −1 1 −1 1 1 −1 −1 −1 1 −1 1 −1 1 1 1 1 −1 −1 1 1 −1 −1 −1 −1 −1 −1 |
| | −1 −1 −1 1 −1 1 −1 −1 1 1 −1 1 −1 −1 1 −1 1 1 1 1 −1 −1 −1 −1 −1 −1 −1 −1 −1 |
| | −1 1 −1 1 1 −1 −1 1 1 1 1 −1 1 1 1 −1 1 1 −1 1 1 −1 −1 1 −1 −1 −1 1 −1 1 −1 −1 1 |
| | 1 1 1 −1 −1 1 −1 1 1 −1 −1 −1 −1 −1 1 −1 1 1 1 1 1 1 1 1 −1 1 −1 1 1 1 1 1 −1 −1 |
| | −1 −1 1 −1 1 1 −1 1 1 1 −1 1 1 1 −1 −1 −1 1 1 1 −1 −1 1 1 −1 −1 −1 −1 −1 1 −1 1 |
| | −1 −1 −1 −1 −1 −1 −1 1 1 1 −1 −1 −1 1 1 1 −1 1 −1 −1 1 1 1 1 1 1 1 −1 1 1 −1 −1 |
| | 1 −1 1 1 −1 −1 −1 −1 1 1 1 1 −1 1 −1 1 1 −1 1 1 1 −1 1 −1 −1 1 1 1 −1 −1 −1 −1 1 |
| | −1 −1 1 −1 −1 1 −1 −1 −1 −1 1 −1 −1 1 −1 −1 −1 1 1 1 1 −1 1 1 1 1 1 1 −1 1 1 −1 |
| | −1 −1 1 −1 −1 1 1 1 1 1 −1 −1 −1 1 1 −1 −1 1 1 1 −1 −1 −1 1 1 −1 1 1 1 −1 −1 1 |
| | −1 −1 −1 −1 1 1 −1 1 1 −1 1 1 −1 −1 1 −1 1 −1 −1 −1 −1 −1 1 1 1 −1 1 1 −1 1 −1 |
| | −1 −1 −1 −1 1 −1 −1 1 1 −1 −1 −1 −1 −1 −1 1 1 1 −1 1 −1 1 1 1 −1 1 −1 1 −1 1 1 |
| | 1 −1 1 −1 1 −1 −1 1 −1 −1 −1 −1 −1 −1 −1 −1 −1 1 −1 −1 −1 1 1 −1 −1 −1 −1 −1 |
| | −1 −1 −1 1 1 1 1 1 −1 −1 1 −1 −1 −1 1 1 −1 1 −1 −1 1 −1 1 −1 −1 −1 1 1 1 1 1 −1 |
| | 1 1 1 1 1 −1 −1 1 1 −1 −1 −1 1 1 1 1 1 1 −1 1 1 1 1 −1 −1 −1 1 1 −1 −1 −1 −1 −1 1 |
| | 1 1 −1 −1 −1 −1 −1 −1 1 −1 1 1 −1 1 −1 −1 −1 −1 1 −1 −1 1 1 −1 −1 1 1 1 1 −1 −1 |
| | −1 1 1 1 −1 −1 −1 −1 1 1 1 1 1 −1 −1 −1 1 1 1 −1 −1 1 −1 −1 1 −1 1 −1 −1 −1 1 1 |
| | −1 1 −1 −1 −1 1 −1 1 1 1 −1 −1 1 −1 −1 1 −1 1 1 −1 1 1 −1 −1 −1 −1 −1 1 1 1 1 1 |
| | 1 1 1 1 −1 1 1 −1 1 −1 1 −1 −1 1 1 1 −1 −1 −1 −1 −1 −1 1 1 1 −1 −1 −1 −1 1 −1 |
| | −1 −1 −1 1 1 1 −1 1 −1 1 1 −1 −1 −1 −1 −1 −1 −1 1 1 1 1 1 1 −1 −1 −1 1 −1 −1 1 |
| | −1 −1 −1 1 1 −1 1 1 1 −1 1 −1 1 1 1 1 −1 −1 −1 −1 −1 1 −1 1 −1 1 1 1 1 1 1 −1 −1 |
| | 1 1 1 1 −1 1 1 1 1 1 −1 −1 −1 1 1 −1 1 1 −1 1 1 −1 1 1 1 1 1 −1 1 −1 −1 −1 1 −1 |
| | −1 1 1 1 −1 −1 −1 1 −1 −1 1 1 1 −1 −1 1 1 1 −1 −1 1 −1 −1 −1 −1 1 −1 −1 −1 1 1 |
| | 1 −1 −1 −1 −1 −1 −1 −1 −1 −1 1 1 1 1 −1 −1 1 1 1 −1 1 1 1 1 1 1 −1 1 −1 −1 1 −1 |
| | −1 −1 1 1 1 −1 1 −1 −1 −1 −1 −1 −1 −1 −1 −1 1 1 −1 1 1 −1 −1 1 −1 −1 1 −1 1 −1 |
| | 1 1 −1 −1 1 −1 1 1 −1 −1 1 −1 −1 1 −1 1 1 1 −1 −1 1 1 1 1 1 1 −1 −1 −1 −1 1 1 −1 |
| | 1 1 1 −1 1 1 −1 −1 −1 −1 1 1 1 −1 1 −1 1 −1 −1 1 −1 1 −1 1 −1 1 −1 1 −1 1 1 −1 1 |
| | 1 1 −1 1 1 −1 −1 1 −1 −1 1 −1 −1 −1 −1 1 1 −1 −1 −1 1 −1 −1 1 1 −1 −1 −1 1 1 1 |
| | −1 −1 −1 1 −1 −1 −1 −1 −1 1 1 −1 −1 −1 −1 1 −1 1 1 −1 −1 −1 −1 1 −1 −1 −1 1 |
| | −1 1 −1 −1 −1 −1 −1 −1 1 1 −1 1 1 −1 1 1 1 −1 −1 −1 −1 −1 1 −1 −1 1 1 −1 1 −1 1 |
| | −1 1 1 −1 1 −1 −1 −1 −1 1 1 −1 −1 1 1 −1 −1 1 1 −1 −1 1 −1 1 1 −1 1 −1 −1 1 1 1 |
| | 1 −1 −1 1 1 1 −1 −1 1 −1 1 −1 1 1 1 −1 1 1 1 −1 −1 1 −1 −1 −1 1 1 −1 −1 −1 1 1 1 |
| | 1 1 −1 −1 −1 1 −1 1 1 −1 −1 −1 1 1 1 −1 −1 1 −1 1 1 1 −1 −1 −1 1 1 −1 1 −1 −1 |
| | 1 1 −1 1 1 1 −1 −1 −1 1 −1 1 −1 −1 1 1 −1 −1 1 1 −1 1 −1 −1 −1 1 1 1 1 1 −1 −1 1 |
| | −1 1 −1 −1 1 1 1 1 −1 1 1 1 1 −1 −1 1 −1 −1 1 1 1 1 1 1 −1 −1 1 1 −1 −1 1 −1 −1 |
| | −1 −1 −1 −1 1 1 −1 −1 −1 1 −1 −1 −1 1 1 −1 1 1 −1 1 −1 1 −1 −1 −1 −1 −1 1 1 1 1 |
| | 1 −1 −1 −1 −1 1 −1 −1 1 1 1 −1 1 1 1 1 −1 −1 1 −1 1 1 −1 1 −1 1 −1 −1 −1 −1 1 1 |
| | −1 1 −1 1 1 −1 −1 1 1 1 −1 1 1 −1 1 1 1 −1 1 −1 −1 −1 1 −1 −1 1 −1 1 1 −1 1 1 1 |
| | −1 1 −1 1 1 −1 1 1 −1 1 −1 1 1 −1 −1 −1 −1 1 1 1 −1 −1 −1 −1 −1 1 1 1 1 −1 −1 |
| | −1 −1 −1 1 −1 −1 −1 −1 1 −1 1 −1 1 −1 1 1 −1 1 1 −1 −1 −1 1 1 −1 −1 −1 −1 −1 |
| | −1 1 −1 −1 1 −1 1 −1 −1 −1 −1 −1 1 −1 1 1 1 −1 −1 −1 −1 −1 1 −1 1 1 −1 −1 −1 |
| | −1 −1 −1 1 −1 −1 −1 −1 −1 −1 1 −1 1 −1 1 1 1 −1 1 −1 −1 1 1 −1 1 1 1 1 −1 1 1 1 |
| | 1 1 −1 1 −1 −1 1 1 1 −1 −1 1 −1 −1 −1 1 1 1 −1 1 1 −1 1 −1 1 −1 1 −1 −1 −1 1 1 1 |
| | 1 −1 1 −1 −1 −1 −1 −1 1 −1 −1 −1 1 1 −1 1 −1 1 −1 1 −1 1 1 1 −1 1 −1 −1 −1 1 1 |
| | 1 −1 1 −1 −1 1 −1 1 −1 1 −1 1 1 1 1 1 −1 −1 −1 1 1 1 1 −1 −1 −1 1 1 1 1 −1 1 −1 |
| | −1 1 −1 1 1 1 −1 1 1 1 1 1 1 1 1 1 −1 1 1 1 1 −1 −1 1 −1 −1 −1 1 −1 1 −1 1 1 |
| | −1 1 −1 −1 1 1 −1 −1 1 1 −1 −1 −1 1 −1 −1 1 −1 1 1 1 −1 −1 −1 1 −1 1 −1 1 1 −1 |
| | −1 1 1 −1 −1 1 1 −1 1 1 1 1 −1 −1 −1 −1 −1 −1 1 −1 1 −1 −1 −1 −1 1 −1 1 1 −1 1 |
| | 1 −1 −1 −1 1 −1 −1 1 −1 1 −1 1 1 −1 1 1 1 1 −1 −1 1 1 −1 1 1 1 1 1 1 1 1 1 1 −1 1 |
| | 1 1 1 1 1 1 −1 −1 1 1 1 −1 1 −1 −1 −1 −1 −1 1 −1 1 −1 −1 1 1 1 1 1 −1 −1 −1 −1 1 |
| | 1 −1 −1 1 −1 −1 −1 1 1 −1 −1 1 1 −1 1 −1 1 1 −1 −1 −1 −1 −1 1 −1 −1 1 −1 1 −1 1 |
| | −1 1 −1 −1 −1 −1 1 1 1 −1 1 −1 −1 1 1 −1 1 −1 1 −1 −1 −1 1 −1 1 1 1 1 1 −1 1 1 |
| | −1 1 −1 1 1 −1 −1 1 −1 −1 1 −1 −1 1 −1 −1 1 1 −1 1 1 −1 1 1 −1 −1 −1 −1 −1 −1 1 |
| | −1 1 −1 1 −1 1 1 1 1 −1 −1 1 −1 −1 1 −1 1 −1 1 −1 −1 1 1 1 1 −1 −1 −1 −1 −1 1 1 |
| | −1 1 −1 −1 −1 −1 −1 1 1 1 −1 −1 1 1 1 1 −1 1 −1 −1 −1 −1 1 1 1 −1 1 1 −1 −1 1 1 |
| | 1 1 1 −1 1 −1 −1 −1 1 1 −1 −1 1 −1 −1 1 −1 1 1 −1 −1 1 1 −1 1 −1 1 1 1 −1 1 −1 1 |
| | 1 1 −1 1 1 1 1 1 −1 1 1 1 −1 −1 −1 1 1 −1 −1 1 1 −1 −1 1 −1 −1 1 1 1 1 −1 −1 1 1 |
| | −1 −1 1 1 1 1 1 1 1 −1 −1 −1 1 1 −1 1 −1 −1 −1 1 1 1 −1 1 1 −1 −1 −1 −1 −1 −1 |
| | −1 1 −1 1 −1 1 −1 −1 1 −1 1 1 −1 −1 −1 −1 −1 −1 −1 −1 1 −1 1 −1 1 1 −1 −1 −1 |
| | −1 1 1 −1 −1 1 −1 1 −1 −1 1 1 −1 −1 1 −1 −1 −1 −1 1 −1 −1 1 1 −1 1 1 −1 1 −1 −1 |
| | 1 −1 1 −1 1 1 −1 −1 −1 −1 −1 1 1 −1 −1 −1 −1 −1 −1 −1 1 1 −1 1 −1 1 1 −1 1 1 −1 |
| | 1 1 1 −1 −1 1 −1 1 1 1 −1 −1 1 −1 −1 −1 −1 −1 1 1 1 −1 −1 −1 1 −1 1 1 1 1 −1 −1 |
| | 1 1 −1 1 −1 1 −1 1 −1 1 −1 1 1 1 1 −1 1 1 1 −1 −1 −1 −1 −1 1 1 −1 −1 1 1 1 1 1 −1 |
| | −1 1 1 1 −1 −1 1 1 1 1 1 −1 1 1 1 1 −1 −1 1 1 −1 −1 1 −1 1 −1 1 −1 1 1 −1 −1 −1 1 |
| | 1 1 −1 −1 1 −1 1 1 1 1 1 −1 1 1 1 1 1 1 −1 −1 1 1 −1 1 1 1 −1 1 −1 1 −1 1 −1 −1 1 |
| | −1 1 −1 1 1 1 1 1 1 1 −1 −1 1 −1 1 1 1 1 −1 1 −1 −1 −1 −1 −1 −1 −1 1 −1 −1 1 1 1 |
| | −1 −1 −1 −1 −1 1 1 −1 1 1 −1 1 −1 1 1 −1 1 −1 1 1 −1 1 1 −1 −1 1 −1 −1 1 1 1 1 1 |
| | −1 −1 1 1 −1 −1 1 1 −1 1 −1 1 −1 −1 1 −1 1 −1 −1 −1 −1 −1 −1 −1 −1 1 −1 −1 1 |
| | −1 −1 1 1 1 1 1 −1 1 1 −1 −1 1 1 −1 −1 1 1 1 1 −1 1 −1 −1 1 −1 −1 1 −1 −1 −1 1 |
| | −1 1 1 −1 1 1 1 1 −1 −1 −1 1 1 1 −1 1 −1 1 1 −1 1 −1 1 −1 1 −1 −1 1 1 −1 1 −1 −1 |
| | −1 −1 −1 1 −1 1 1 −1 −1 1 −1 1 −1 −1 −1 1 −1 −1 1 −1 −1 −1 1 −1 −1 −1 1 −1 −1 |
| | −1 −1 1 −1 1 −1 −1 −1 −1 1 1 1 −1 −1 −1 1 1 −1 −1 −1 −1 1 1 −1 1 1 −1 1 −1 −1 1 |
| | 1 1 1 1 −1 −1 1 −1 −1 1 1 −1 −1 −1 −1 1 1 −1 −1 −1 1 −1 1 1 −1 −1 1 −1 −1 1 1 1 |
| | −1 1 1 −1 −1 1 1 −1 1 −1 −1 −1 −1 1 −1 1 −1 −1 1 1 −1 −1 −1 1 1 1 1 −1 1 1 1 −1 |
| | 1 −1 −1 −1 1 1 −1 −1 −1 −1 1 1 1 1 −1 −1 −1 −1 1 1 1 −1 1 −1 −1 −1 1 1 1 1 1 1 |
| | −1 −1 −1 −1 −1 1 1 1 −1 1 1 1 1 1 −1 1 −1 1 1 −1 1 1 −1 −1 −1 −1 1 1 −1 1 −1 1 |
| | −1 1 1 −1 −1 −1 1 −1 1 1 −1 −1 −1 −1 1 1 −1 1 1 1 1 1 −1 −1 1 −1 1 1 1 −1 −1 −1 |
| | −1 1 −1 1 −1 −1 1 1 1 −1 1 1 −1 1 −1 −1 1 −1 1 1 1 −1 −1 1 −1 1 −1 1 −1 −1 1 −1 |
| | −1 −1 1 1 1 1 1 1 −1 1 −1 1 −1 −1 1 −1 −1 1 −1 1 −1 1 −1 1 1 −1 1 −1 −1 1 −1 −1 |
| | 1 1 −1 −1 1 −1 1 1 −1 −1 −1 1 1 −1 1 −1 −1 −1 −1 1 −1 −1 −1 1 1 −1 −1 1 −1 1 −1 |
| | 1 −1 −1 1 1 −1 1 1 −1 1 −1 1 1 1 1 1 1 −1 −1 −1 1 −1 1 1 1 −1 1 1 −1 −1 1 −1 1 1 |
| | 1 −1 1 −1 −1 1 −1 1 −1 −1 −1 −1 1 −1 1 −1 −1 −1 1 1 −1 1 1 −1 1 1 1 1 −1 1 −1 1 |
| | 1 1 −1 1 −1 −1 −1 −1 1 −1 −1 −1 −1 1 1 −1 −1 −1 −1 −1 1 1 −1 −1 1 −1 1 −1 1 1 |
| | −1 −1 1 1 1 −1 −1 1 1 1 −1 1 1 1 −1 1 −1 −1 −1 −1 1 1 −1 1 −1 −1 1 1 −1 −1 1 −1 |
| | −1 1 −1 −1 −1 1 1 −1 −1 1 −1 −1 −1 −1 −1 1 1 −1 −1 1 −1 −1 −1 −1 1 1 −1 −1 1 1 |
| | 1 −1 −1 1 1 −1 −1 −1 1 −1 −1 −1 −1 −1 1 −1 −1 1 −1 1 1 1 1 1 1 −1 1 −1 1 −1 1 1 |
| | 1 −1 −1 −1 −1 −1 1 1 1 −1 −1 1 −1 1 −1 −1 −1 −1 1 −1 −1 −1 1 −1 −1 1 1 1 1 1 1 |
| | −1 1 1 −1 −1 1 1 1 −1 −1 1 −1 1 1 1 −1 1 1 1 −1 1 −1 1 1 1 −1 −1 1 −1 1 −1 −1 −1 |
| | 1 1 1 −1 1 1 1 −1 1 −1 1 −1 1 1 −1 −1 −1 −1 −1 −1 1 1 −1 1 −1 1 −1 −1 −1 1 1 1 |
| | −1 1 −1 1 1 1 1 1 1 1 1 1 −1 1 −1 −1 −1 −1 −1 −1 1 1 1 −1 −1 1 −1 −1 −1 1 −1 1 1 |
| | 1 −1 −1 −1 −1 1 1 1 1 −1 −1 1 −1 −1 1 −1 −1 −1 −1 −1 1 1 −1 1 1 1 −1 1 −1 −1 1 |
| | −1 1 1 −1 1 −1 −1 −1 −1 −1 −1 1 1 −1 −1 1 1 1 −1 1 1 −1 −1 1 −1 −1 −1 −1 1 −1 1 |
| | 1 −1 −1 −1 1 1 1 −1 1 1 1 1 −1 1 −1 1 −1 −1 1 −1 1 1 1 1 1 1 1 1 1 1 1 1 −1 1 −1 1 |
| | −1 1 −1 1 1 −1 1 −1 1 1 1 −1 −1 1 1 −1 1 1 1 −1 −1 −1 −1 −1 −1 −1 1 1 −1 −1 −1 |
| | −1 1 1 1 −1 −1 1 −1 1 1 −1 1 −1 −1 −1 1 −1 1 1 −1 −1 1 1 1 −1 −1 −1 1 −1 −1 −1 |
| | 1 −1 −1 1 1 −1 1 −1 1 1 1 −1 −1 −1 −1 1 −1 −1 −1 1 1 −1 1 1 1 1 1 1 1 −1 1 −1 −1 |
| | −1 1 −1 1 1 −1 1 1 −1 1 1 −1 1 1 −1 1 −1 −1 −1 −1 1 −1 1 1 −1 −1 1 1 −1 1 1 1 −1 |
| | 1 1 1 1 1 1 −1 −1 −1 1 1 1 −1 1 1 1 −1 −1 −1 −1 −1 −1 1 1 −1 −1 1 −1 1 1 1 −1 −1 |
| | 1 1 −1 1 −1 1 1 −1 1 −1 1 −1 −1 −1 1 1 −1 −1 −1 −1 −1 1 −1 1 1 −1 1 −1 1 −1 1 1 |
| | 1 −1 −1 1 −1 1 1 −1 1 1 −1 1 1 1 1 −1 −1 −1 −1 1 −1 −1 −1 −1 −1 1 −1 −1 −1 −1 |
| | −1 1 −1 1 −1 1 −1 −1 −1 −1 −1 1 1 −1 1 −1 −1 1 −1 1 1 −1 1 1 −1 1 −1 1 −1 −1 1 |
| | −1 1 1 −1 1 −1 1 −1 1 −1 1 1 −1 −1 −1 −1 1 −1 −1 1 1 1 1 1 −1 1 −1 −1 1 1 −1 −1 |
| | 1 1 1 −1 1 1 1 −1 −1 −1 1 −1 1 1 −1 −1 1 1 −1 −1 1 −1 −1 −1 1 −1 1 1 −1 −1 1 −1 |
| | 1 1 −1 1 1 1 −1 −1 −1 −1 1 1 1 −1 −1 1 1 1 −1 −1 −1 −1 1 −1 1 1 1 −1 −1 −1 1 −1 |
| | −1 −1 −1 1 1 −1 −1 1 −1 1 1 −1 −1 1 1 −1 −1 −1 −1 1 −1 −1 −1 −1 1 −1 1 1 1 1 1 |
| | −1 −1 −1 1 −1 1 −1 −1 1 −1 −1 1 1 −1 −1 −1 −1 −1 1 1 −1 1 1 1 1 1 1 −1 −1 −1 −1 |
| | 1 −1 −1 −1 1 −1 −1 −1 1 −1 1 −1 1 1 1 1 1 −1 −1 1 1 −1 1 −1 −1 1 −1 1 −1 1 −1 |
| | −1 1 −1 1 −1 −1 1 −1 1 −1 1 −1 −1 −1 −1 −1 −1 1 1 1 1 −1 −1 −1 1 −1 −1 −1 1 −1 |
| | 1 1 −1 −1 −1 −1 1 1 1 −1 1 −1 1 −1 1 1 1 1 1 1 1 1 −1 −1 −1 −1 1 −1 1 −1 −1 |
| | −1 1 −1 −1 −1 1 1 1 −1 1 1 1 1 1 1 1 1 1 −1 −1 −1 1 −1 1 −1 1 1 1 −1 −1 1 1 −1 −1 |
| | 1 −1 −1 1 −1 1 −1 −1 1 1 −1 −1 −1 −1 1 −1 1 1 1 −1 1 −1 −1 −1 1 −1 1 1 1 1 −1 |
| | −1 −1 1 1 1 1 1 1 1 −1 −1 −1 −1 1 1 1 1 −1 1 1 1 −1 −1 −1 1 −1 −1 1 1 −1 −1 1 1 |
| | −1 1 1 −1 1 1 −1 1 −1 1 −1 1 1 1 1 −1 −1 −1 −1 1 1 1 1 1 1 −1 1 1 −1 1 1 −1 1 1 |
| | −1 −1 −1 1 −1 1 1 1 1 1 1 −1 −1 1 −1 1 −1 −1 −1 1 −1 1 1 1 −1 1 1 1 −1 −1 −1 −1 |
| | 1 −1 −1 1 1 −1 −1 −1 1 −1 1 1 −1 1 1 1 −1 −1 1 −1 −1 1 −1 −1 1 1 1 −1 −1 1 −1 |
| | −1 1 1 −1 1 1 1 −1 −1 1 1 1 1 1 −1 −1 1 −1 1 1 −1 −1 1 −1 1 1 1 1 −1 1 1 −1 1 −1 |
| | 1 −1 1 1 −1 1 1 −1 1 −1 −1 1 1 −1 1 −1 −1 1 1 1 −1 1 −1 −1 1 −1 −1 1 −1 1 −1 −1 |
| | −1 −1 1 1 1 1 −1 1 1 −1 −1 1 −1 −1 −1 1 1 1 1 −1 −1 1 −1 1 −1 1 1 1 1 1 −1 1 1 −1 |
| | −1 −1 −1 1 1 −1 −1 −1 −1 −1 −1 1 1 −1 −1 −1 −1 −1 1 −1 −1 1 1 1 1 1 1 1 1 −1 −1 |
| | 1 1 −1 1 −1 1 1 1 1 1 1 1 −1 1 1 1 1 −1 1 −1 −1 1 1 −1 1 −1 −1 −1 1 −1 −1 −1 −1 1 |
| | 1 −1 1 1 1 1 −1 −1 1 1 1 1 −1 1 −1 1 −1 1 1 −1 1 1 1 1 1 −1 −1 1 1 1 −1 1 1 −1 1 |
| | −1 1 1 1 1 −1 1 1 −1 1 1 1 1 1 −1 −1 −1 1 −1 −1 −1 1 1 1 −1 −1 1 −1 1 −1 1 −1 1 1 |
| | 1 −1 1 1 −1 1 1 −1 1 1 1 −1 1 1 1 1 −1 1 1 −1 1 1 −1 1 −1 −1 1 −1 −1 −1 −1 1 1 −1 |
| | 1 −1 −1 −1 1 1 −1 −1 −1 1 1 −1 1 −1 −1 1 −1 −1 −1 1 −1 −1 1 −1 1 1 1 1 −1 1 1 1 |
| | 1 1 1 1 1 −1 −1 1 −1 −1 −1 −1 −1 1 −1 1 1 −1 1 1 1 1 1 −1 1 1 −1 1 1 1 −1 −1 1 1 |
| | 1 −1 1 1 −1 −1 −1 −1 1 −1 1 1 1 1 1 1 −1 1 1 1 1 1 −1 1 1 −1 −1 1 −1 −1 1 1 −1 1 |
| | −1 −1 1 1 −1 −1 −1 −1 1 1 1 −1 1 1 1 1 −1 −1 −1 −1 −1 1 1 1 1 1 −1 1 −1 1 1 1 −1 |
| | −1 1 1 1 1 −1 1 1 −1 1 −1 −1 1 −1 −1 1 −1 −1 1 1 1 1 −1 −1 −1 1 1 −1 −1 1 −1 1 1 |
| | −1 1 1 −1 −1 1 −1 1 1 −1 1 −1 1 1 −1 1 −1 −1 1 1 1 −1 −1 1 1 −1 1 1 −1 1 1 1 1 1 |
| | 1 1 1 −1 1 1 1 −1 1 −1 1 1 −1 −1 1 1 1 1 1 −1 −1 −1 1 −1 −1 1 1 −1 1 1 −1 −1 −1 1 |
| | 1 1 1 1 1 1 1 −1 1 −1 −1 1 −1 1 −1 −1 1 −1 −1 −1 −1 −1 1 −1 1 −1 −1 −1 1 −1 1 |
| | −1 −1 1 −1 −1 −1 1 1 −1 1 −1 1 1 1 1 1 −1 1 1 1 −1 1 −1 −1 1 1 −1 −1 1 −1 1 1 1 |
| | −1 1 1 −1 −1 −1 −1 −1 1 −1 −1 −1 −1 −1 −1 −1 −1 −1 −1 −1 1 −1 −1 1 1 −1 −1 1 |
| | −1 1 −1 −1 1 −1 −1 1 1 1 −1 1 −1 1 1 −1 −1 1 −1 1 −1 1 1 −1 1 1 −1 1 1 −1 −1 1 1 |
| | 1 1 −1 1 −1 1 1 1 −1 −1 −1 1 −1 1 1 1 −1 −1 1 1 −1 −1 −1 −1 1 1 1 1 1 −1 1 −1 −1 |
| | 1 −1 −1 1 1 −1 1 1 1 1 −1 −1 1 −1 1 −1 −1 −1 −1 −1 −1 1 −1 −1 −1 1 1 1 −1 1 −1 |
| | 1 −1 1 −1 1 −1 1 −1 1 −1 −1 −1 1 −1 −1 −1 1 −1 1 1 1 −1 1 −1 1 1 −1 1 −1 −1 −1 |
| | −1 −1 1 1 −1 −1 1 1 −1 1 −1 −1 1 1 −1 1 −1 1 1 −1 1 1 1 1 −1 1 1 −1 −1 −1 1 −1 1 |
| | 1 −1 1 −1 1 1 −1 −1 −1 1 1 −1 1 1 −1 1 −1 −1 −1 1 −1 1 −1 −1 1 1 −1 1 1 −1 −1 |
| | −1 −1 1 −1 1 −1 1 −1 1 −1 −1 −1 1 1 −1 1 1 1 1 −1 1 −1 −1 −1 −1 1 −1 1 1 1 −1 |
| | −1 1 1 1 −1 1 −1 −1 1 −1 1 1 1 1 1 −1 1 −1 1 −1 1 −1 −1 1 1 1 1 1 −1 1 −1 1 1 −1 |
| | −1 1 1 −1 1 −1 −1 1 −1 −1 −1 −1 −1 1 1 1 1 −1 1 1 1 1 −1 1 1 1 −1 −1 1 −1 1 1 −1 |
| | −1 1 1 1 −1 1 −1 −1 −1 1 −1 −1 −1 −1 −1 1 1 1 −1 1 −1 −1 −1 −1 1 −1 1 −1 1 1 −1 |
| | −1 1 −1 −1 1 1 −1 −1 −1 1 1 −1 −1 1 −1 −1 −1 1 −1 −1 1 1 −1 −1 −1 −1 1 −1 −1 1 |
| | −1 −1 −1 −1 1 −1 1 1 1 −1 1 1 −1 1 1 1 1 −1 1 1 1 −1 1 1 1 1 −1 −1 1 1 1 −1 −1 −1 |
| | −1 −1 −1 −1 1 −1 −1 1 −1 1 1 −1 1 −1 1 1 1 1 1 −1 −1 1 −1 −1 −1 −1 1 1 1 1 −1 |
| | −1 −1 1 1 −1 1 1 1 1 −1 −1 −1 1 −1 1 1 1 1 1 −1 −1 1 1 1 1 1 −1 −1 −1 −1 −1 1 1 |
| | −1 −1 −1 1 −1 1 −1 −1 1 1 1 −1 −1 1 1 1 1 −1 −1 −1 1 −1 1 1 −1 1 −1 −1 1 1 −1 1 |
| | 1 −1 −1 1 −1 −1 −1 −1 −1 −1 −1 1 1 −1 1 1 1 −1 −1 −1 1 1 1 1 −1 −1 1 1 −1 1 −1 |
| | −1 −1 −1 −1 −1 −1 −1 1 1 −1 −1 −1 1 1 −1 1 1 −1 −1 −1 1 −1 −1 −1 −1 −1 −1 −1 |
| | 1 1 1 1 −1 1 1 −1 1 1 1 −1 1 1 −1 1 1 1 −1 −1 −1 1 −1 −1 −1 1 1 −1 −1 1 1 1 1 1 1 |
| | −1 −1 1 −1 −1 1 1 1 −1 1 −1 −1 1 1 −1 −1 −1 −1 −1 1 −1 −1 −1 1 −1 1 −1 1 −1 1 |
| | −1 1 1 −1 −1 1 −1 −1 −1 1 1 −1 1 1 −1 −1 −1 −1 −1 1 −1 1 −1 1 −1 1 −1 1 −1 −1 1 |
| | 1 1 −1 1 1 1 1 1 −1 −1 −1 −1 1 1 1 −1 −1 −1 1 −1 −1 1 −1 1 1 −1 −1 1 −1 −1 −1 |
| | −1 −1 1 −1 −1 1 1 1 −1 1 −1 1 −1 −1 1 1 1 1 1 1 1 1 1 −1 −1 1 1 1 1 1 1 −1 1 −1 1 |
| | 1 −1 −1 −1 1 1 1 1 −1 −1 −1 −1 1 −1 1 1 1 1 −1 1 1 1 −1 1 −1 1 −1 −1 1 1 −1 1 −1 |
| | 1 −1 1 −1 −1 −1 −1 1 −1 1 1 1 1 −1 −1 1 −1 −1 −1 −1 −1 −1 −1 −1 1 1 1 −1 1 1 −1 |
| | −1 −1 1 −1 1 −1 −1 −1 −1 −1 1 1 −1 −1 −1 1 1 1 1 −1 −1 1 −1 −1 −1 −1 1 −1 1 −1 |
| | −1 1 −1 −1 1 −1 −1 1 −1 1 −1 −1 1 −1 −1 1 −1 1 1 1 1 1 −1 −1 −1 −1 −1 −1 −1 1 1 |
| | 1 −1 1 −1 −1 1 −1 −1 −1 −1 −1 −1 1 −1 1 1 1 −1 1 1 1 1 −1 1 −1 −1 −1 1 1 1 1 −1 |
| | 1 1 −1 1 −1 1 1 1 −1 −1 −1 1 1 1 −1 1 1 −1 −1 1 −1 1 −1 1 1 1 1 −1 −1 −1 1 1 −1 1 |
| | −1 1 −1 −1 1 −1 −1 −1 1 −1 1 −1 1 −1 −1 −1 −1 1 1 −1 −1 −1 −1 1 1 −1 −1 1 1 1 1 |
| | −1 −1 1 1 −1 1 1 −1 1 −1 1 −1 1 −1 1 −1 −1 1 −1 1 1 1 −1 1 −1 1 −1 1 −1 1 1 1 1 1 |
| | 1 −1 1 1 −1 1 −1 −1 −1 1 1 −1 1 1 −1 −1 1 −1 1 1 1 1 1 1 −1 −1 −1 −1 −1 −1 1 −1 |
| | −1 −1 1 −1 1 1 1 1 1 1 1 −1 −1 −1 −1 −1 1 −1 1 1 1 −1 1 −1 1 −1 −1 −1 −1 1 −1 1 |
| | −1 1 −1 −1 1 1 1 −1 −1 1 −1 1 −1 −1 1 −1 −1 −1 1 −1 −1 −1 −1 −1 1 −1 1 1 1 1 −1 |
| | 1 −1 1 1 1 1 1 1 −1 1 −1 −1 −1 −1 1 −1 −1 1 −1 −1 1 1 −1 1 −1 −1 −1 1 1 −1 1 −1 |
| | −1 1 1 1 1 −1 1 1 −1 1 1 −1 −1 −1 1 1 1 −1 1 −1 1 −1 −1 −1 −1 −1 −1 −1 −1 −1 −1 |
| | 1 1 1 −1 −1 1 1 −1 1 1 1 1 −1 1 −1 1 −1 1 1 1 1 −1 1 −1 1 1 −1 1 −1 1 1 1 1 −1 −1 |
| | 1 1 1 −1 1 −1 1 −1 1 −1 −1 −1 −1 −1 −1 −1 1 −1 1 1 −1 1 1 −1 1 −1 −1 −1 1 1 1 1 |
| | −1 −1 1 1 1 1 1 −1 1 −1 1 −1 −1 1 1 −1 −1 −1 −1 −1 −1 −1 1 −1 −1 −1 −1 −1 1 1 1 |
| | 1 1 1 −1 1 −1 −1 −1 1 1 1 −1 −1 −1 1 1 1 1 1 1 −1 −1 1 −1 1 1 −1 1 1 1 1 −1 1 −1 |
| | −1 1 −1 −1 −1 −1 1 −1 −1 −1 −1 1 −1 −1 1 −1 1 −1 −1 1 −1 1 1 1 1 −1 1 −1 1 −1 1 |
| | −1 1 −1 −1 −1 −1 −1 1 −1 −1 −1 −1 1 1 1 1 1 1 1 −1 −1 1 −1 −1 1 −1 1 1 1 1 −1 |
| | −1 1 −1 1 −1 1 −1 1 −1 1 1 1 −1 −1 −1 1 −1 −1 1 −1 −1 1 1 −1 −1 −1 1 −1 −1 1 1 |
| | 1 −1 1 1 −1 1 1 −1 −1 −1 −1 1 −1 −1 −1 −1 −1 −1 −1 1 −1 1 −1 −1 −1 1 1 1 1 −1 |
| | −1 −1 1 −1 1 −1 −1 −1 −1 1 1 −1 −1 1 −1 −1 1 1 −1 −1 1 1 −1 −1 1 1 1 −1 −1 −1 |
| | −1 1 1 1 −1 1 1 −1 1 1 −1 1 −1 1 1 1 −1 1 −1 −1 1 −1 −1 −1 1 −1 1 1 1 1 −1 1 −1 |
| | −1 1 −1 1 −1 1 1 1 −1 1 −1 1 1 −1 −1 −1 1 −1 1 −1 −1 1 −1 1 1 −1 −1 1 −1 1 −1 1 |
| | −1 −1 −1 1 1 1 −1 −1 −1 −1 1 −1 1 −1 1 1 −1 1 1 1 −1 −1 1 1 −1 −1 −1 1 1 −1 1 |
| | −1 1 1 1 −1 1 1 1 −1 1 1 1 −1 1 1 −1 −1 −1 1 1 −1 1 1 1 1 1 −1 1 1 1 1 −1 1 1 −1 |
| | −1 1 1 1 1 −1 −1 −1 −1 1 −1 −1 1 −1 1 1 1 −1 1 −1 −1 −1 −1 −1 −1 1 −1 1 1 −1 −1 |
| | −1 1 −1 1 1 1 −1 1 −1 −1 1 1 1 1 −1 1 −1 −1 −1 1 1 −1 1 1 1 −1 −1 −1 −1 1 −1 1 1 |
| | −1 −1 1 −1 −1 −1 1 −1 −1 −1 1 1 −1 1 −1 −1 −1 −1 −1 −1 1 −1 −1 1 1 −1 1 1 1 1 1 |
| | −1 −1 −1 −1 −1 1 −1 −1 1 −1 −1 −1 −1 −1 −1 −1 1 −1 −1 −1 1 −1 −1 1 −1 1 −1 1 |
| | −1 −1 −1 1 −1 1 1 −1 1 −1 −1 −1 1 1 1 −1 −1 1 1 −1 1 −1 1 −1 −1 −1 −1 −1 −1 1 |
| | −1 1 −1 −1 1 −1 −1 −1 −1 1 1 1 1 1 −1 1 1 −1 −1 −1 1 1 −1 −1 1 −1 1 −1 −1 −1 1 |
| | 1 −1 −1 −1 1 −1 −1 −1 −1 1 1 1 −1 −1 −1 −1 1 1 −1 1 −1 −1 1 −1 −1 1 1 1 −1 −1 |
| | −1 −1 1 1 −1 −1 −1 1 1 1 −1 −1 1 1 1 −1 1 −1 1 1 1 1 −1 1 −1 1 −1 −1 −1 −1 −1 1 |
| | −1 1 −1 1 1 −1 1 −1 1 1 −1 −1 1 1 −1 −1 −1 1 1 1 −1 1 −1 −1 −1 1 −1 1 −1 1 −1 |
| | −1 1 −1 −1 1 1 −1 1 −1 1 −1 −1 1 1 1 1 −1 1 −1 1 −1 −1 1 1 1 −1 1 −1 1 −1 1 1 −1 |
| | 1 −1 1 −1 1 1 −1 −1 1 1 1 1 −1 −1 1 −1 −1 −1 1 1 1 1 1 −1 −1 −1 −1 −1 −1 1 1 −1 |
| | 1 1 1 1 −1 1 1 −1 1 −1 −1 −1 −1 1 1 1 −1 −1 1 1 −1 −1 1 −1 1 1 1 1 1 −1 −1 1 −1 1 |
| | −1 1 1 −1 1 −1 −1 −1 1 1 −1 −1 1 1 −1 −1 −1 −1 1 1 −1 1 −1 −1 −1 −1 1 1 −1 1 1 |
| | −1 −1 1 1 −1 −1 −1 −1 −1 −1 1 −1 1 1 1 1 1 −1 1 −1 −1 −1 −1 −1 1 1 −1 1 1 −1 −1 |
| | −1 −1 1 1 1 1 1 1 1 1 −1 −1 −1 1 1 1 1 1 −1 1 1 −1 1 −1 −1 1 1 −1 −1 −1 1 1 −1 1 |
| | 1 1 −1 1 1 1 −1 1 −1 −1 1 −1 −1 1 1 1 1 −1 1 −1 −1 1 1 −1 −1 −1 1 −1 −1 −1 1 −1 |
| | −1 −1 1 1 1 1 1 −1 1 −1 1 −1 1 1 −1 −1 1 −1 1 −1 −1 1 1 1 −1 −1 −1 1 −1 1 1 −1 1 |
| | 1 −1 −1 1 1 1 −1 −1 −1 −1 −1 1 −1 −1 −1 1 1 1 1 1 1 1 1 1 1 1 −1 −1 −1 −1 −1 −1 |
| | −1 −1 1 −1 −1 −1 −1 1 1 −1 1 −1 1 −1 −1 1 1 −1 1 1 1 1 1 1 −1 1 −1 1 1 1 −1 1 1 |
| | −1 1 −1 −1 −1 1 −1 −1 −1 1 1 −1 −1 −1 1 −1 1 −1 1 1 −1 1 1 −1 −1 1 1 −1 −1 1 −1 |
| | 1 −1 −1 −1 −1 1 1 −1 1 1 1 −1 −1 1 1 −1 1 −1 −1 1 1 1 1 1 1 −1 −1 −1 1 1 −1 −1 |
| | −1 1 −1 −1 1 −1 −1 1 −1 −1 1 −1 −1 −1 1 1 1 −1 −1 −1 1 −1 1 −1 1 −1 −1 1 1 −1 |
| | −1 1 1 1 1 1 −1 1 1 −1 1 1 −1 −1 1 1 −1 1 1 1 1 1 −1 1 −1 1 −1 −1 −1 1 1 −1 1 −1 |
| | 1 −1 −1 −1 −1 1 −1 −1 −1 −1 −1 1 1 −1 1 −1 1 1 1 1 −1 −1 −1 1 −1 −1 −1 −1 −1 |
| | −1 1 1 −1 1 −1 −1 −1 1 −1 −1 1 −1 −1 1 1 1 −1 1 1 1 −1 −1 1 1 1 1 −1 −1 1 1 1 1 |
| | −1 −1 −1 −1 −1 −1 1 1 1 1 −1 1 −1 −1 −1 1 −1 −1 −1 1 −1 −1 1 −1 −1 −1 −1 −1 1 |
| | −1 −1 −1 1 −1 −1 −1 −1 −1 −1 −1 −1 1 −1 1 1 1 −1 −1 1 −1 1 1 1 1 −1 −1 −1 1 −1 |
| | 1 −1 1 −1 1 1 −1 −1 1 1 −1 1 1 −1 −1 −1 1 −1 1 −1 1 −1 1 −1 −1 1 1 −1 −1 −1 1 |
| | −1 1 −1 −1 −1 1 −1 −1 1 1 −1 1 1 1 −1 1 1 −1 1 −1 1 1 −1 1 1 1 −1 −1 −1 1 1 −1 1 |
| | 1 −1 −1 1 1 1 −1 1 −1 1 −1 −1 −1 1 −1 1 −1 1 −1 1 1 1 −1 −1 1 1 1 −1 −1 −1 1 1 1 |
| | 1 −1 1 1 −1 −1 −1 −1 1 −1 −1 1 −1 1 −1 1 1 1 1 −1 1 −1 −1 1 1 1 1 1 −1 1 1 1 −1 |
| | −1 1 1 −1 −1 1 1 −1 −1 −1 −1 −1 1 1 1 1 −1 1 −1 1 −1 −1 −1 1 −1 −1 −1 −1 −1 −1 |
| | 1 −1 −1 −1 −1 1 −1 −1 −1 −1 −1 −1 1 1 1 1 1 −1 1 1 1 −1 1 1 −1 −1 1 1 −1 −1 −1 |
| | 1 −1 1 1 1 1 −1 1 1 −1 −1 −1 −1 −1 −1 1 1 1 1 1 1 1 −1 1 1 1 −1 −1 −1 −1 1 1 −1 |
| | −1 1 1 −1 1 1 −1 −1 1 1 1 1 1 1 1 1 −1 1 1 −1 −1 −1 −1 −1 1 1 −1 1 −1 1 −1 1 −1 |
| | −1 1 −1 −1 −1 −1 1 −1 1 −1 1 1 1 −1 −1 −1 1 1 −1 −1 −1 1 1 −1 −1 −1 1 1 1 −1 1 |
| | 1 −1 1 1 1 1 1 1 −1 1 1 1 −1 1 1 1 −1 −1 1 1 −1 1 1 −1 −1 1 −1 1 −1 1 −1 1 −1 −1 |
| | 1 −1 −1 1 −1 −1 −1 −1 −1 −1 1 1 1 −1 1 1 1 −1 1 1 1 1 1 −1 −1 1 −1 −1 1 −1 −1 1 |
| | −1 1 1 −1 −1 −1 1 1 1 1 1 −1 1 −1 −1 −1 −1 1 1 −1 −1 −1 1 1 −1 −1 1 1 −1 1 1 1 |
| | −1 −1 1 −1 1 −1 1 1 −1 −1 −1 1 −1 −1 1 1 −1 1 −1 −1 1 −1 −1 1 −1 1 1 −1 1 −1 −1 |
| | 1 −1 1 −1 −1 1 1 −1 1 −1 1 1 1 1 −1 1 −1 −1 −1 1 −1 1 −1 −1 −1 1 1 1 −1 −1 1 −1 |
| | −1 −1 −1 −1 −1 1 −1 −1 1 −1 −1 −1 1 −1 1 −1 −1 −1 1 −1 1 1 −1 −1 −1 1 −1 −1 1 |
| | −1 −1 −1 −1 1 1 1 −1 1 1 1 −1 −1 1 −1 1 −1 −1 1 1 −1 1 1 1 −1 1 −1 −1 −1 −1 −1 |
| | 1 1 1 1 −1 −1 1 −1 1 1 1 −1 1 −1 1 1 1 1 1 −1 1 −1 1 1 1 1 −1 −1 1 −1 1 1 1 1 1 1 1 |
| | −1 1 −1 1 −1 −1 −1 −1 1 1 1 1 1 1 −1 −1 1 1 1 −1 −1 −1 1 −1 1 −1 −1 −1 1 1 −1 |
| | −1 1 1 1 −1 1 −1 −1 1 1 1 −1 1 −1 1 1 1 −1 −1 −1 −1 −1 −1 1 −1 −1 1 1 1 1 −1 1 |
| | −1 1 1 −1 −1 1 −1 −1 −1 −1 1 1 1 −1 −1 1 −1 −1 1 1 1 1 −1 1 1 −1 −1 1 1 −1 1 1 |
| | −1 1 −1 −1 −1 −1 −1 −1 −1 1 1 −1 −1 1 −1 −1 1 −1 −1 1 1 −1 −1 1 1 1 −1 −1 1 −1 |
| | −1 1 −1 −1 −1 1 −1 −1 1 1 1 −1 1 −1 −1 −1 1 1 −1 1 −1 1 1 −1 1 −1 −1 −1 1 −1 −1 |
| | 1 1 −1 −1 1 −1 −1 −1 1 1 1 −1 −1 1 1 1 1 1 1 1 −1 1 −1 −1 1 1 1 1 −1 −1 −1 1 −1 |
| | −1 1 1 1 1 −1 −1 1 −1 −1 1 1 −1 1 −1 1 1 −1 −1 1 −1 1 1 1 −1 −1 −1 1 1 1 1 1 −1 |
| | −1 1 1 1 1 −1 −1 1 −1 1 −1 −1 1 −1 1 −1 −1 −1 1 −1 1 −1 1 1 1 −1 1 1 −1 −1 1 1 1 |
| | −1 1 1 1 1 −1 1 1 1 1 −1 −1 −1 −1 1 1 −1 1 −1 1 1 1 −1 −1 1 −1 −1 −1 1 −1 −1 1 |
| | −1 −1 1 −1 1 1 1 −1 1 1 −1 1 −1 1 −1 −1 −1 1 −1 −1 1 −1 1 −1 −1 −1 1 −1 −1 −1 |
| | −1 1 −1 −1 −1 1 −1 1 1 −1 1 −1 1 −1 −1 1 −1 −1 1 1 1 1 1 1 1 −1 −1 1 1 −1 −1 −1 |
| | −1 1 −1 1 −1 1 1 1 1 −1 1 1 −1 −1 1 −1 1 −1 −1 1 −1 1 1 −1 1 1 1 1 1 1 1 −1 −1 −1 |
| | 1 −1 −1 −1 −1 1 −1 −1 1 1 1 1 −1 −1 −1 −1 1 1 −1 −1 −1 −1 1 −1 −1 1 1 −1 1 −1 |
| | −1 −1 −1 1 1 1 1 −1 −1 1 1 −1 −1 −1 1 −1 1 −1 1 −1 −1 −1 1 1 −1 −1 1 −1 1 1 1 1 |
| | −1 −1 1 1 1 1 1 1 1 1 1 1 −1 −1 1 −1 1 −1 1 −1 −1 −1 −1 1 −1 −1 1 −1 1 1 −1 −1 |
| | −1 −1 1 −1 1 −1 −1 −1 −1 −1 1 −1 −1 1 −1 −1 1 −1 1 −1 1 1 1 −1 −1 −1 −1 1 1 −1 |
| | 1 1 −1 −1 −1 1 1 −1 1 −1 1 −1 1 1 1 −1 1 1 1 1 −1 −1 −1 1 −1 −1 1 −1 1 −1 −1 1 1 |
| | 1 −1 1 −1 −1 −1 −1 1 1 1 1 1 −1 −1 1 1 −1 1 1 |

FIG. 8 is a diagram of a cumulative distribution function of cross-correlation results between 16 selected sequences. In FIG. 8, a horizontal axis shows a normalized cross correlation peak, and a vertical axis shows a value of the CDF. It can be learned that the normalized cross-correlation peak (namely, the second threshold) is between −36 dB and −28 dB, and the 16 sequences have a low cross-correlation feature.

S620: The sending device sends the PPDU to a receiving device. Correspondingly, the receiving device receives the PPDU from the sending device.

S630: The receiving device performs ranging or sensing measurement based on the PPDU. For this step, refer to the descriptions in S430. Details are not described herein again.

It can be learned that, in the method, different sampling sequences are constructed based on an in-sequence having a low-correlation zone, and a sequence set having a low cross-correlation is selected from the sampling sequences. The m-sequence having a low-correlation zone may well support sensing measurement and ranging. In addition, sequences in the sequence set have a low cross-correlation, and may support a plurality of devices to perform concurrent transmission, to reduce interference when the plurality of devices simultaneously perform sensing or ranging.

It should be understood that, the method provided in this application may also be used to generate an SHR, to perform synchronization, channel estimation, or the like.

It should be understood that sequence numbers of the foregoing processes do not mean execution sequences. The execution sequence of the processes should be determined based on functions and internal logic of the processes, and should not be construed as any limitation on implementation processes of embodiments of this application.

It should be further understood that, in embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

It should be further understood that, in some of the foregoing embodiments, a device in an existing network architecture is mainly used as an example for description. It should be understood that a specific form of the device is not limited in embodiments of this application. For example, all devices that can implement a same function in the future are applicable to embodiments of this application.

It may be understood that, in the foregoing method embodiments, methods and operations implemented by the devices (for example, the sending device and the receiving device) may alternatively be implemented by a component (for example, a chip or a circuit) of the device.

The foregoing describes the method provided in embodiments of this application in detail with reference to FIG. 1 to FIG. 8. The foregoing methods are mainly described from a perspective of interaction between the sending device and the receive device. It may be understood that, to implement the foregoing functions, the sending device and the receiving device include corresponding hardware structures and/or software modules for performing the functions.

A person skilled in the art should be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

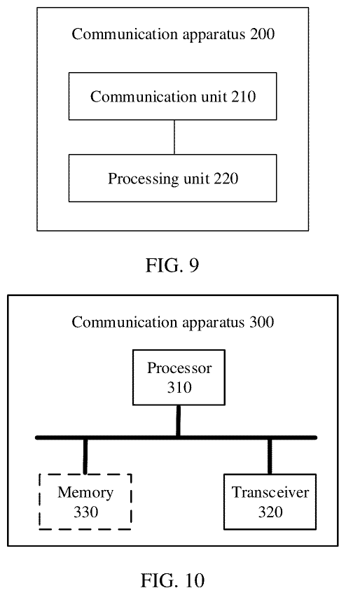

With reference to FIG. 9 and FIG. 10, the following describes in detail communication apparatuses provided in embodiments of this application. It should be understood that descriptions of apparatus embodiments correspond to the descriptions of the method embodiments. Therefore, for content that is not described in detail, refer to the method embodiments above. For brevity, details of a part of content are not described herein again. In embodiments of this application, the sending device and the receiving device may be divided into functional modules based on the method examples, for example, each functional module may be obtained through division based on each corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used. An example in which each functional module is obtained through division based on each corresponding function is used below for description.

The foregoing describes in detail the data transmission method provided in this application, and the following describes communication apparatuses provided in this application. In a possible implementation, the apparatus is configured to implement the steps or procedures corresponding to the receive end device in the foregoing method embodiments. In another possible implementation, the apparatus is configured to implement the steps or procedures corresponding to the transmit end device in the foregoing method embodiments.

FIG. 9 is a block diagram of a communication apparatus 200 according to an embodiment of this application. As shown in FIG. 9, the apparatus 200 may include a communication unit 210 and a processing unit 220. The communication unit 210 may communicate with the outside, and the processing unit 220 is configured to process data. The communication unit 210 may also be referred to as a communication interface or a transceiver unit.

In a possible design, the apparatus 200 may implement steps or procedures performed by the transmit end device in the foregoing method embodiments. The processing unit 220 is configured to perform processing-related operations of the transmit end device in the foregoing method embodiments, and the communication unit 210 is configured to perform sending-related operations of the transmit end device in the foregoing method embodiments.

In another possible design, the apparatus 200 may implement steps or procedures performed by the receive end device in the foregoing method embodiments. The communication unit 210 is configured to perform receiving-related operations of the receive end device in the foregoing method embodiments, and the processing unit 220 is configured to perform processing-related operations of the receive end device in the foregoing method embodiments.

It should be understood that the apparatus 200 herein is embodied in a form of a functional unit. The term “unit” herein may be an application-specific integrated circuit (application-specific integrated circuit, ASIC), an electronic circuit, a processor (for example, a shared processor, a dedicated processor, or a group processor) configured to execute one or more software or firmware programs, a memory, a merged logic circuit, and/or another proper component that supports the described function. In an optional example, a person skilled in the art may understand that the apparatus 200 may be specifically the transmit end device in the foregoing embodiments, and may be configured to perform procedures and/or steps corresponding to the sending device in the foregoing method embodiments. Alternatively, the apparatus 200 may be specifically the receiving device in the foregoing embodiments, and may be configured to perform procedures and/or steps corresponding to the receive end device in the foregoing method embodiments. To avoid repetition, details are not described herein again.

The apparatus 200 in each of the foregoing solutions has functions of implementing corresponding steps performed by the transmit end device in the foregoing method, or the apparatus 200 in each of the foregoing solutions has functions of implementing corresponding steps performed by the receive end device in the foregoing methods. The function may be implemented by hardware, or may be implemented by hardware executing corresponding software. The hardware or software includes one or more modules corresponding to the foregoing function. For example, the communication unit may be replaced with a transceiver (for example, a sending unit of the communication unit may be replaced with a transmitter, and a receiving unit of the communication unit may be replaced with a receiver), and another unit such as the processing unit may be replaced with a processor, to separately perform the sending/receiving operations and the processing-related operations in the method embodiments.

In addition, alternatively, the communication unit may be a transceiver circuit (for example, may include a receiving circuit and a sending circuit), and the processing unit may be a processing circuit. In this embodiment of this application, the apparatus in FIG. 9 may be the sending device or the receiving device in the foregoing embodiments, or may be a chip or a chip system, for example, a system on chip (system on chip, SoC). The communication unit may be an input/output circuit or a communication interface. The processing unit is a processor, a microprocessor, or an integrated circuit integrated on the chip. This is not limited herein.

FIG. 10 is a block diagram of a communication apparatus 300 according to an embodiment of this application. The apparatus 300 includes a processor 310 and a transceiver 320. The processor 310 and the transceiver 320 communicate with each other through an internal connection path, and the processor 310 is configured to execute instructions, to control the transceiver 320 to send a signal and/or receive a signal.

Optionally, the apparatus 300 may further include a memory 330. The memory 330 communicates with the processor 310 and the transceiver 320 through internal connection paths. The memory 330 is configured to store instructions, and the processor 310 may execute the instructions stored in the memory 330. In a possible implementation, the apparatus 300 is configured to implement procedures and steps corresponding to the transmit end device in the foregoing method embodiments. In another possible implementation, the apparatus 300 is configured to implement procedures and steps corresponding to the receive end device in the foregoing method embodiments.

It should be understood that the apparatus 300 may be specifically the sending device or the receiving device in the foregoing embodiments, or may be a chip or a chip system. Correspondingly, the transceiver 320 may be a transceiver circuit of the chip. This is not limited herein. Specifically, the apparatus 300 may be configured to perform steps and/or procedures corresponding to the transmit end device or the receive end device in the foregoing method embodiments. Optionally, the memory 330 may include a read-only memory and a random access memory, and provide instructions and data for the processor. A part of the memory may further include a non-volatile random access memory. For example, the memory may further store information of a device type. The processor 310 may be configured to execute the instructions stored in the memory; and when the processor 310 executes the instructions stored in the memory, the processor 310 is configured to perform steps and/or procedures corresponding to the transmit end device or the receive end device in the foregoing method embodiments.

In an implementation process, steps in the foregoing methods can be implemented by using a hardware integrated logic circuit in the processor, or by using instructions in a form of software. The steps of the methods disclosed with reference to embodiments of this application may be directly performed and completed by a hardware processor, or may be performed and completed by using a combination of hardware in the processor and a software module. A software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor. To avoid repetition, details are not described herein again.

It should be noted that, the processor in embodiments of this application may be an integrated circuit chip, and has a signal processing capability. In an implementation process, steps in the foregoing method embodiments can be implemented by using a hardware integrated logic circuit in the processor, or by using instructions in a form of software. The processor may be a general purpose processor, a digital signal processor (DSP), an application-specific integrated circuit (ASIC), a field programmable gate array (FPGA) or another programmable logic device, a discrete gate or a transistor logic device, or a discrete hardware component. The processor in embodiments of this application may implement or perform the methods, the steps, and the logical block diagrams that are disclosed in embodiments of this application. The general-purpose processor may be a microprocessor, or the processor may be any conventional processor, or the like. The steps of the methods disclosed with reference to embodiments of this application may be directly performed and completed by a hardware decoding processor, or may be performed and completed by using a combination of hardware in the decoding processor and a software module. A software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor.

It may be understood that the memory in this embodiment of this application may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus dynamic random access memory (direct rambus RAM, DR RAM). It should be noted that the memory of the systems and methods described in this specification includes but is not limited to these memories and any memory of another proper type.

It should be noted that, when the processor is a general purpose processor, a DSP, an ASIC, an FPGA or another programmable logic device, a discrete gate or a transistor logic device, or a discrete hardware component, the memory (storage module) may be integrated into the processor.

In addition, this application further provides a computer-readable storage medium. The computer-readable storage medium stores computer instructions. When the computer instructions are run on a computer, operations and/or procedures performed by the sending device or the receiving device in the method embodiments of this application are performed.

This application further provides a computer program product. The computer program product includes computer program code or instructions. When the computer program code or the instructions are run on a computer, operations and/or procedures performed by the sending device or the receiving device in the method embodiments of this application are performed.

In addition, this application further provides a chip, and the chip includes a processor. A memory configured to store a computer program is disposed independent of the chip. The processor is configured to execute the computer program stored in the memory, so that an operation and/or processing performed by the sending device or the receiving device in any method embodiment are/is performed.

Further, the chip may include a communication interface. The communication interface may be an input/output interface, an interface circuit, or the like. Further, the chip may include a memory.

In addition, this application further provides a communication system, including the sending device and the receiving device in embodiments of this application.

It should further be noted that the memory described in this specification is intended to include but is not limited to these memories and any memory of another proper type.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application. It may be clearly understood by a person skilled in the art that, for the purpose of convenient and brief description, for a detailed working process of the foregoing system, apparatus, and unit, refer to a corresponding process in the foregoing method embodiments. Details are not described herein again. In the several embodiments provided in this application, it should be understood that the disclosed system, apparatus, and method may be implemented in other manners. For example, the described apparatus embodiment is merely an example. For example, division into the units is merely logical functional division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms. The units described as separate parts may or may not be physically separate, and parts displayed as units may or may not be physical units, may be located in one place, or may be distributed on a plurality of network units. Some or all of the units may be selected based on actual requirements to achieve the objectives of the solutions of embodiments. In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in the form of a software product. The computer software product is stored in a storage medium and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a ROM, a RAM, a magnetic disk, or an optical disc.

It should be understood that, an “embodiment” mentioned throughout this specification means that particular features, structures, or characteristics related to this embodiment are included in at least one embodiment of this application. Therefore, embodiments throughout this specification do not necessarily mean a same embodiment. In addition, these particular features, structures, or characteristics may be combined in one or more embodiments by using any proper manner.

It should be further understood that ordinal numbers such as “first” and “second” mentioned in embodiments of this application are used to distinguish between a plurality of objects, and are not intended to limit sizes, content, an order, a time sequence, priorities, importance, or the like of the plurality of objects. For example, the first information and the second information do not indicate a difference in an information amount, content, a priority, importance, or the like.

It should be further understood that, the term “and/or” in this specification describes only an association relationship between associated objects, and represents that three relationships may exist. For example, A and/or B may represent the following cases: A exists alone, both A and B exist, and B exists alone, where A and B may be singular or plural. The character “/” usually indicates an “or” relationship between the associated objects. For example, A/B indicates A or B.

It should be further understood that in embodiments of this application, “B corresponding to A” indicates that B is associated with A, and B may be determined based on A. However, it should be further understood that determining B based on A does not mean that B is determined based on only A, and B may be further determined based on A and/or other information.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-23. (canceled)

24. A physical layer protocol data unit sending method, comprising:
generating a physical layer protocol data unit (PPDU), wherein the PPDU comprises a first field, the first field is used for ranging or sensing measurement, the first field is generated based on a first sequence in a sequence set or an equivalent deformation sequence of the first sequence, the sequence set comprises M zero-correlation zone sequences, the M zero-correlation zone sequences are sequences in L1! zero-correlation zone sequences whose lengths are 2^{L}, a cross-correlation between any two sequences in the M zero-correlation zone sequences is less than or equal to a first threshold, a sequence in the L1! zero-correlation zone sequences is generated based on the first sequence and a second sequence, the first sequence is a complementary pair sequence in L1! pairs of Golay complementary pair sequences whose lengths are 2^{L1}, the second sequence is a pair of Golay complementary pair sequences that have a zero-correlation zone and whose sequence length is 2^{L2}, the L1! zero-correlation zone sequences and the L1! pairs of Golay complementary pair sequences are in a one-to-one correspondence, L1, L2, and M are all positive integers, and L1+L2=L; and
sending the PPDU.

25. The method according to claim 24, wherein a sequence eₘ in the L1! zero-correlation zone sequences satisfies the following formula:
$${e}_{m} = c ⊗ \frac{{a}_{m} + {b}_{m}}{2} - d ⊗ \frac{{b}_{m} - {a}_{m}}{2} ,$$
(aₘ, bₘ) is a pair of sequences in the L1! pairs of Golay complementary pair sequences, (c, d) is a pair of Golay complementary pair sequences that have a zero-correlation zone, and 0≤m≤L1!−1.

26. The method according to claim 24, wherein a Golay complementary pair sequence whose length is 2ⁿ is constructed and generated based on functions f(x) and g(x), and f(x) and g(x) meet the following condition:
$$f ( x ) = {\sum }_{k = 1}^{n - 1} {x}_{π ( k )} {x}_{π ( k + 1 )} + {\sum }_{k = 1}^{n} {c}_{k} {x}_{k} + {c}_{0} ; and$$
$$g ( x ) = f ( x ) + {x}_{π ( 1 )} ,$$
wherein
π is a permutation of a set {1, 2, . . . , n}, the set {1, 2, . . . , n} comprises n! permutations, xⱼ is a value of a j^{th} bit when x is written in binary, j=1, 2, . . . , n, when a permutation of the set {1, 2, . . . , n} is used and a value of x is obtained by traversing from 0 to 2ⁿ−1, f(x) and g(x) respectively correspond to sequences p and q whose lengths are 2ⁿ, the sequences p and q are a pair of Golay complementary pair sequences, cₖ∈{0, 1}, and c₀∈{0, 1}.

27. The method according to claim 24, wherein the equivalent deformation sequence of the first sequence comprises a sequence generated by negating the first sequence or reversing the first sequence.

28. A physical layer protocol data unit receiving method, comprising:
receiving a physical layer protocol data unit (PPDU), wherein the PPDU comprises a first field, the first field is used for ranging or sensing measurement, the first field is generated based on a first sequence in a sequence set or an equivalent deformation sequence of the first sequence, the sequence set comprises M zero-correlation zone sequences, the M zero-correlation zone sequences are sequences in L1! zero-correlation zone sequences whose lengths are 2^{L}, a cross-correlation between any two sequences in the M zero-correlation zone sequences is less than or equal to a first threshold, a sequence in the L1! zero-correlation zone sequences is generated based on the first sequence and a second sequence, the first sequence is a complementary pair sequence in L1! pairs of Golay complementary pair sequences whose lengths are 2^{L1}, the second sequence is a pair of Golay complementary pair sequences that have a zero-correlation zone and whose sequence length is 2^{L2}, the L1! zero-correlation zone sequences and the L1! pairs of Golay complementary pair sequences are in a one-to-one correspondence, L1, L2, and M are all positive integers, and L1+L2=L; and
performing ranging or sensing measurement based on the PPDU.

29. The method according to claim 28, wherein a sequence eₘ in the L1! zero-correlation zone sequences satisfies the following formula:
$${e}_{m} = c ⊗ \frac{{a}_{m} + {b}_{m}}{2} - d ⊗ \frac{{b}_{m} - {a}_{m}}{2} ,$$
(aₘ, bₘ) is a pair of sequences in the L1! pairs of Golay complementary pair sequences, (c, d) is a pair of Golay complementary pair sequences that have a zero-correlation zone, and 0≤m≤L1!−1.

30. The method according to claim 28, wherein a Golay complementary pair sequence whose length is 2ⁿ is constructed and generated based on functions f(x) and g(x), and f(x) and g(x) meet the following condition:
$$f ( x ) = {\sum }_{k = 1}^{n - 1} {x}_{π ( k )} {x}_{π ( k + 1 )} + {\sum }_{k = 1}^{n} {c}_{k} {x}_{k} + {c}_{0} ; and$$
$$g ( x ) = f ( x ) + {x}_{π ( 1 )} ,$$
wherein
π is a permutation of a set {1, 2, . . . , n}, the set {1, 2, . . . , n} comprises n! permutations, xⱼ is a value of a j^{th} bit when x is written in binary, j=1, 2, . . . , n, when a permutation of the set {1, 2, . . . , n} is used and a value of x is obtained by traversing from 0 to 2ⁿ−1, f(x) and g(x) respectively correspond to sequences p and q whose lengths are 2ⁿ, the sequences p and q are a pair of Golay complementary pair sequences, cₖ∈{0, 1}, and c₀∈{0, 1}.

31. The method according to claim 28, wherein the equivalent deformation sequence of the first sequence comprises a sequence generated by negating the first sequence or reversing the first sequence.

32. A physical layer protocol data unit sending apparatus, comprising:
a processing unit, configured to generate a physical layer protocol data unit (PPDU), wherein the PPDU comprises a first field, the first field is used for ranging or sensing measurement, the first field is generated based on a first sequence in a sequence set or an equivalent deformation sequence of the first sequence, the sequence set comprises M zero-correlation zone sequences, the M zero-correlation zone sequences are sequences in L1! zero-correlation zone sequences whose lengths are 2^{L}, a cross-correlation between any two sequences in the M zero-correlation zone sequences is less than or equal to a first threshold, a sequence in the L1! zero-correlation zone sequences is generated based on the first sequence and a second sequence, the first sequence is a complementary pair sequence in L1! pairs of Golay complementary pair sequences whose lengths are 2^{L1}, the second sequence is a pair of Golay complementary pair sequences that have a zero-correlation zone and whose sequence length is 2^{L2}, the L1! zero-correlation zone sequences and the L1! pairs of Golay complementary pair sequences are in a one-to-one correspondence, L1, L2, and M are all positive integers, and L1+L2=L; and
a communication unit, configured to send the PPDU.

33. The apparatus according to claim 32, wherein a sequence eₘ in the L1! zero-correlation zone sequences satisfies the following formula:
$${e}_{m} = c ⊗ \frac{{a}_{m} + {b}_{m}}{2} - d ⊗ \frac{{b}_{m} - {a}_{m}}{2} ,$$
wherein
(aₘ, bₘ) is a pair of sequences in the L1! pairs of Golay complementary pair sequences, (c, d) is a pair of Golay complementary pair sequences that have a zero-correlation zone, and 0≤m≤L1!−1.

34. The apparatus according to claim 32, wherein a Golay complementary pair sequence whose length is 2ⁿ is constructed and generated based on functions f(x) and g(x), and f(x) and g(x) meet the following condition:
$$f ( x ) = {\sum }_{k = 1}^{n - 1} {x}_{π ( k )} {x}_{π ( k + 1 )} + {\sum }_{k = 1}^{n} {c}_{k} {x}_{k} + {c}_{0} ; and$$
$$g ( x ) = f ( x ) + {x}_{π ( 1 )} ,$$
wherein
π is a permutation of a set {1, 2, . . . , n}, the set {1, 2, . . . , n} comprises n! permutations, xⱼ is a value of a j^{th} bit when x is written in binary, j=1, 2, . . . , n, when a permutation of the set {1, 2, . . . , n} is used and a value of x is obtained by traversing from 0 to 2ⁿ−1, f(x) and g(x) respectively correspond to sequences p and q whose lengths are 2ⁿ, the sequences p and q are a pair of Golay complementary pair sequences, cₖ∈{0, 1}, and c₀∈{0, 1}.

35. The apparatus according to claim 32, wherein the equivalent deformation sequence of the first sequence comprises a sequence generated by negating the first sequence or reversing the first sequence.
